(19) United States
(12) Patent Application Publication
(10) Pub. No.: US 2016/0012465 A1
(43) Pub. Date: Jan. 14, 2016

(54) SYSTEM AND METHOD FOR DISTRIBUTING, RECEIVING, AND USING FUNDS OR CREDITS AND APPARATUS THEREOF

(71) Applicant: Jeffrey A. Sharp, Salt Lake City, UT (US)

(72) Inventor: Jeffrey A. Sharp, Salt Lake City, UT (US)

(21) Appl. No.: 14/616,743

(22) Filed: Feb. 8, 2015

Related U.S. Application Data
(60) Provisional application No. 62/056,518, filed on Sep. 27, 2014.
(60) Provisional application No. 62/053,157, filed on Sep. 21, 2014.
(60) Provisional application No. 62/040,402, filed on Aug. 21, 2014.
(60) Provisional application No. 62/038,808, filed on Aug. 18, 2014.
(60) Provisional application No. 62/037,599, filed on Aug. 14, 2014.
(60) Provisional application No. 62/032,533, filed on Aug. 2, 2014.
(60) Provisional application No. 62/024,465, filed on Jul. 14, 2014.
(60) Provisional application No. 62/012,343, filed on Jun. 14, 2014.
(60) Provisional application No. 62/009,149, filed on Jun. 6, 2014.
(60) Provisional application No. 61/994,816, filed on May 16, 2014.
(60) Provisional application No. 61/989,491, filed on May 6, 2014.
(60) Provisional application No. 61/981,848, filed on Apr. 20, 2014.
(60) Provisional application No. 61/981,779, filed on Apr. 19, 2014.
(60) Provisional application No. 61/978,998, filed on Apr. 14, 2014.
(60) Provisional application No. 61/975,940, filed on Apr. 7, 2014.
(60) Provisional application No. 61/973,369, filed on Apr. 1, 2014.
(60) Provisional application No. 61/948,004, filed on Mar. 4, 2014.
(60) Provisional application No. 61/943,376, filed on Feb. 23, 2014.
(60) Provisional application No. 61/940,483, filed on Feb. 16, 2014.
(60) Provisional application No. 61/939,806, filed on Feb. 14, 2014.
(60) Provisional application No. 61/937,517, filed on Feb. 8, 2014.
(60) Provisional application No. 62/062,919, filed on Oct. 12, 2014.

(51) Int. Cl. G06Q 30/02; H04W 4/14; G06Q 20/10

(52) U.S. Cl. CPC G06Q 30/0215; G06Q 20/10; H04W 4/14

(57) ABSTRACT

A system for performing various methods of sending, receiving, distributing, and utilizing funds and/or credits is disclosed. In many embodiments, various communications platforms and/or protocols may be employed. Methods of sending funds or credits may be practiced in different environments, including physical and electronic environments. According to some preferred embodiments, users may perform a variety of transactions including various gifting functions, re-gifting functions, and social interactions simply, through various types of electronic communications, including, but not limited to electronic messaging.

### CROSS REFERENCE TO RELATED APPLICATIONS

This application claims the benefit of U.S. Provisional Patent Application No. 62/062,919 filed on 12 Oct. 2014, which claims the benefit of U.S. Provisional Patent Application No. 62/056,518 filed on 27 Sep. 2014, which claims the benefit of U.S. Provisional Patent Application No. 62/053,157 filed on 21 Sep. 2014, which claims the benefit of U.S. Provisional Patent Application No. 62/040,402 filed on 21 Aug. 2014, which claims the benefit of U.S. Provisional Patent Application No. 62/038,808 filed on 18 Aug. 2014, which claims the benefit of U.S. Provisional Patent Application No. 62/037,599 filed on 14 Aug. 2014, which claims the benefit of U.S. Provisional Patent Application No. 62/032,553 filed on 2 Aug. 2014, which claims the benefit of U.S. Provisional Patent Application No. 62/024,465 filed on 14 Jul. 2014, which claims the benefit of U.S. Provisional Patent Application No. 62/012,343 filed on 14 Jun. 2014, which claims priority to U.S. Provisional Patent Application No. 62/009,149 filed on 6 Jun. 2014, which claims priority to U.S. Provisional Patent Application No. 61/994,816 filed on 16 May 2014, which claims priority to U.S. Provisional Patent Application No. 61/989,491 filed on 6 May 2014, which claims priority to U.S. Provisional Patent Application No. 61/981,848 filed on 20 Apr. 2014, which claims priority to U.S. Provisional Patent Application No. 61/981,779 filed on 19 Apr. 2014, which claims priority to U.S. Provisional Patent Application No. 61/978,998 filed on 14 Apr. 2014, which claims priority to U.S. Provisional Patent Application No. 61/975,940 filed on 7 Apr. 2014, which claims priority to U.S. Provisional Patent Application No. 61/973,369 filed on 1 Apr. 2014, which claims priority to U.S. Provisional Patent Application No. 61/948,004 filed on 4 Mar. 2014, which claims priority to U.S. Provisional Patent Application No. 61/943,376 filed on 23 Feb. 2014, which claims priority to U.S. Provisional Patent Application No. 61/940,483 filed on 16 Feb. 2014, which claims priority to U.S. Provisional Patent Application No. 61/939,806 filed on 14 Feb. 2014, which claims priority to U.S. Provisional Patent Application No. 61/937,517 filed on 8 Feb. 2014, all of which are hereby incorporated by reference in their entirety, and for any and all purposes as if fully set forth herein.

### TECHNICAL FIELD

Some embodiments may relate to methods of distributing and dispersing funds or credits received at a first location to a second location.

Some embodiments may relate to methods of distributing and dispersing funds or credits received at a first location, using one or more security features, to a second location.

Some embodiments may utilize a reusable system card to perform a variety of functions including making changes or updates to user profiles (e.g., social, shopping, and other online networks), purchasing items, transferring/sending funds or credits, receiving funds or credits, adding items to digital wish lists, saving or posting favorable opinions of products or services, redeeming funds or credits between various locations, and/or recommending items to contacts, relatives, or friends.

Some embodiments may relate to methods of using an integrated system card, integrated card, mobile device, website platform, and optional system application to facilitate shopping experiences.

Further embodiments may relate to a gift card with smart card capabilities, which may be used for gifting purposes, without physically sending or otherwise delivering the gift card to the intended recipient.

Embodiments may relate to improvements in article manufacturing and dispensing machines and components and methods related to the same, for example, self-service kiosk apparatus and systems and methods for authenticating funds or credits, wherein the self-service kiosk apparatus may be advantageously utilized to purchase, convert, transfer/send, distribute, receive, bundle, or redeem funds or credits between various locations via physical article production means.

Some embodiments may relate to methods of gifting and sharing information utilizing a mobile device.

Yet further embodiments may relate to methods of buying, gifting, determining what a user likes/wants, and/or sharing information utilizing a mobile device or a computing device having internet or other network connectivity.

Embodiments may relate to methods of buying and/or gifting to a unique vanity address utilizing a mobile device or a computing device having internet or other network connectivity, wherein the vanity address may be associated with one or more electronic addresses of a single individual/entity, or the vanity address may be associated with one or more electronic addresses, wherein each electronic address is affiliated with a different individual/entity.

Embodiments may relate to methods of making purchases, and making purchases online, using system credit affiliated with a user's electronic address, rather than providing credit card, banking, or checking information as conventionally done to date.

Further embodiments may relate to various combinations of one, two, and multi-way authentication.

According to some embodiments, methods disclosed may be used for online purchases, for example, to send an item to an individual which may comprise an intended recipient, wherein recipient information may be associated with a user performing the methods, or recipient information may be associated with an individual other than a user performing the methods.

Some embodiments may relate to methods of redeeming pre-paid electronic vouchers or coupons received or pre-purchased using a system, wherein the methods disclosed may be used for in-store purchases, or online purchases.

Various methods of using system features are also disclosed and schematically depicted in the appended drawings.

### ANTICIPATED ADVANTAGES

While some embodiments may be often described herein with references to a gift card, system, card-dispensing self-service kiosk, vendor participation system and/or service for improving vendor market opportunities, all which are applications to which embodiments may be advantageously suited, it should be readily apparent that all embodiments are not limited to those particular applications.

For example, cards employed or otherwise utilized may advantageously be provided with a variety of capabilities including, but not limited to, serving as equivalent means to physical or digital currency, tickets, passes, coupons, shopper loyalty cards, and other forms of purchasing media used by consumers and accepted by various vendors/entities.

Moreover, while some embodiments may be described in their most basic or simplistic forms, the system may incorporate the use of, and/or many of the methods described herein may be equally performed using a computer or mobile device via a system “smart” mobile application or system website, without necessarily requiring use of purely SMS/MMS protocols.

Components of the system may be optionally integrated with a plurality of third-party systems, networks, institutions, platforms, and the like. For example, features of apparatus, systems, and methods discussed herein may have equal benefit when applied to gift cards, banking cards, credit cards, insurance cards, drivers licenses, identification cards, customer loyalty cards, social networking applications, mobile wallets, checks, etc.

Some embodiments may advantageously not require only utilizing funds or credits at a particular venue, location, vendor, or selling entity as with conventional gift cards. Some embodiments may be employed with very simple executable programs (e.g., character string identification, sorting, and storing algorithms, basic logic functions, and a limited number of outputs and/or inputs. Moreover, some embodiments may obviate the need for huge support staffs, because all operational decisions could be made or managed at a centralized location (e.g., system website or database) by a management team and/or one or more servers located remote from the transaction locations.

The system may be integrated with one or more SMS/MMS auto-responders/auto dialers for sending push, pull, SMS alerts, one-time passwords (OTP), and the like in an automated fashion. The system may be integrated with an audio-based human-machine interface (HMI). It is anticipated that more complex systems may be employed to provide both robust control environments and flexible and/or scalable operating environments which are able to connect seamlessly to multiple SMSC operators in the country of operation.

Systems described herein may, depending on volume of messages sent, received, pushed, and pulled, comprise simple modems or connecting over leased line using low level communication protocols (e.g., SMPP, UCP, etc.). Systems described herein may cater to providing failover mechanisms and least-cost routing options. Software utilized may be proprietary, open source banking platforms, or the like to support similar functions to that of existing mobile banking and SMS payment systems. Systems, apparatus, and/or methods described herein may comprise means for identifying SMS addresses (e.g., Verizon Wireless® @vtext.com, Cingular® @mobile.mycingular.com, T-Mobile@@tmomail.net, and Boost Mobile @myboostmobile.com), means for identifying mobile device electronic addresses, numbers, etc., and/or software means for removing non-alphanumeric characters and/or spaces. The system may comprise one or more SMS gateways (ETSI, GSM), SMSCs, terminals (e.g., DECT), direct-to-mobile gateway appliances having wireless GSM connectivity, means for allowing SMS/MMS text messages to be sent and/or received by email, from web pages, or from other software applications by acquiring a unique identifier from a mobile device's SIM card, SMS aggregators to provide SMS services to customers, means for regulating number of SMS messages per SIM, ODBC to connect to a system database, HTTP interfaces to interact with third-party applications, one or more direct-to-SMS gateways, means for connecting directly to a mobile operator's SMSC via the internet or direct leased line, short message peer-to-peer (SMPP) protocol, third-party applications (e.g., Microsoft Outlook, AOL Instant Messenger, ICQ, SMS send platform, Windows Live Messenger, Windows SMS Sender, Skype, Yahoo! Messenger, etc.), one or more email clients/programs (e.g., Eudora, Thunderbird, etc.), ASCII “text-only” mode software, HTML-based text software, SMS gateway domains, SMS center numbers, SIM numbers, character count/message size limiting or logistics software, voice-over-IP communication systems, etc., eAPI's (e.g., BulkSMS), ANSI CDMA networks, Digital AMPS, satellite networks, land-line networks, short message mobile terminated (SMS-MT) point-to-point protocols, short message mobile originated (SMS-MO) point-to-point protocols, short message point-to-point (SMS-PP) protocols, optional cell broadcast messaging protocols (SMS-CB) for local users SMSC foreign number blocking means, GSM/3GPP/3G/etc. network communication means, SMS alternative protocols (e.g., J-Phone's SkyMail, NTT Docomo's ShortMail, etc.), STMP over TCP/IP standard mail protocols, “store and forward” mechanisms provided to a SMSC, “forward and forget” mechanisms provided to a SMSC (e.g., for SMS-MO and SMS-MT), satellite communication protocols, user data headers (UDH) and UDH interpreters, data/metadata routers, long SMS components, concentrated SMS components, SMS gateway providers, SMS SS7 connectivity providers, aggregators, local or international termination models, message service centers, public land mobile network (PLMN) communication means, direct-to-mobile gateway appliances, caller ID software, HTTP to SMS API's, TMS protocols, Flash SMS delivery means, dialing and/or messaging short code (i.e., “special shorter phone numbers”) implementations, SMS traffic switching services, mobile web, mobile client applications, mobile channel platforms, SMS with mobile web and secure SMS, push to talk services and/or messaging protocols, mobile dial codes, operator messaging, extended messaging services, CSCA short code registry access means, open mobile alliance (OMA) standards, email-to-SMS services, SMS-to-email services, SMS home-routing, USSD, and SIM application toolkits (STK/SAT/SIM2), USIM Application Toolkits (USAT), Card Application Toolkits (CAT), SIMalliance Toolbox (S@T)-compliant wireless internet browsers (WIB) without limitation.

Furthermore, the cards disclosed herein, when used in combination with a mobile device, may be utilized to make both personal and gift purchases, as well as funds transfers without secondary human interaction, and without dialing a number, in otherwise untraditional venues or locations such as outdoor areas (e.g., baseball stadiums, gas stations, highways while driving, at rest stops, while eating at food establishments, or while walking around a mall or outlet) and other non-conventional points of sale (such as while watching a TV commercial, listening to the radio, watching a puck pass an advertisement board at a hockey game, or looking at discardable food packaging). With certain embodiments, a single person may be able to buy and send several items or amounts of funds to any one of their contacts, relatives, or friends in seconds. Added security may be achieved by combining unique SIM-card data information with unique card data and security codes.

Some embodiments may address the shortcomings of traditional brick- and mortar and online gift card retail, redemption, and exchange systems in a convenient and cost-effective delivery vehicle having the added bonus of serving as an effective promotional platform that drives incremental sales through small purchases and word-of-mouth sharing between contacts, relatives, and friends. In addition, the card apparatuses according to some embodiments may overcome the aforementioned disadvantages by at least offering more vendor/entity choices—for example, one may pay a cab driver, pay a babysitter, or even a landlord without necessarily needing a bank account, a smart phone, or an online payment service account (e.g., PayPal).

Additionally, instances may be avoided where an end user or recipient of a gift card cannot effectively utilize the card due to a lack of vendor locations in their geographic region.

Moreover, with some embodiments, smaller local vendors may be able to easily expand their market by increasing their exposure to more potential customers which wouldn't otherwise expend efforts to visit their brick-and-mortar store or website. Some embodiments may also prove advantageous because the system disclosed, according to some embodiments, may be configured to be integrated with external user profiles and networks. For example, users of the system may set up “wish lists” or “favorites” in their own profiles, making it easier for other users to identify the perfect gift, or shopping list, or users of the system may wish to optionally link third-party accounts such as social networking profiles with the system website, making it easy to auto-populate user information and/or select appropriate gifting and personal products using aggregate marketing data. In some embodiments, codes provided to system cards may comprise “see wish list” codes, wherein a user may text a friend's mobile device number and a “see wish list” code which may be provided on the system card, to a system-provided number, in order to see some, all, or most recently added items (and, in some embodiments, associated prices and/or item codes associated with the items) that the friend wants. According to some embodiments, a user may similarly text a friend's email address, social media profile screen name or user ID, or other electronic address in combination with a “see wish list” code to accomplish similar functions.

Some embodiments may also provide a new vehicle for vendors to more effectively spend their advertising dollars without much waste or environmental impact, while increasing probability of sales due to convenience to the consumer. For example, vendors may spend more advertising dollars for higher levels of visibility to placing indicia to be used by system components on paper goods, advertising vehicles (e.g., radio, TV, billboards, signs, etc). By accessing the system database, vendors may monitor how their promotions are being used, by whom, and where (via location metadata and mobile phone number area code information). User profiles and account information may provide vendors with information about who is actually purchasing their products, products relating to their products, or competitive products to more accurately target their target market base, while also preventing the adverse affects of extreme couponing, mass advertising, paper refuge, expensive commercial productions, and other “see and then forget” types of consumer advertising.

Some embodiments may allow a user to facilitate their shopping and/or gift-purchasing experiences, create shopping or gift-giving lists on a user account (e.g., a phone number account number) supported by a system website and/or database.

Certain embodiments may also help with expanding the number of gifting options for purchasers of gift cards, for example, providing multiple non-related or non-affiliated redemption options to the same gift card, thereby allowing more customized gifting solutions. Furthermore, some embodiments may allow a recipient to chose a closer, or more convenient location or vendor to purchase their favorite goods and/or services—or otherwise use the funds in a more appropriate or logical way. Moreover, some embodiments may provide means for corporations to better track popularity and market interest in certain product lines from a single system, rather than from a myriad of market analysis solutions providers.

Furthermore, the system, apparatus, and methods disclosed herein may, according to some embodiments, provide means for a user of the system to transfer their points, such as rewards points, frequent diner points, club points, membership points, loyalty points etc., to a single card, for example, by scanning or manually entering cards information into a system website with only the need to enter a phone number and card number. Moreover, embodiments of the system, apparatus, and methods disclosed herein may provide means for a user of the system to transfer their own points, such as rewards points, frequent diner points, club points, membership points, loyalty points etc., for one particular unrelated vendor/entity for funds or credits that are recognized or otherwise accepted as a form of payment to a second unrelated vendor/entity. Moreover, some embodiments may provide means for a first user of the system to transfer their own points, such as rewards points, frequent diner points, club points, membership points, loyalty points etc. earned, to a second user (e.g., to contacts, relatives, or friends) in various combinations, allocations, and amounts. Additionally, some embodiments may provide means for a user of the system to convert their own points, such as rewards points, frequent diner points, club points, membership points, loyalty points etc. earned, to another form of funds or credits such as currency (physical or digital/virtual), gift certificates or gift certificate credit, coupons or coupon credit, gift cards or gift card credit, tickets or ticket credit, passes or pass credit, stocks/funds or credit for purchasing stocks/funds, vouchers or voucher credit, prepaid minutes or credit for purchasing prepaid minutes, credit card credits, a check to the user, or a credit to be applied to a check for the user in the future, etc.

Certain embodiments may also allow subscribing users to quickly and readily access remaining balances or rewards balances by texting a “check balances code” (not illustrated) to a system provided number. Accordingly, a user may shop without the worry of forgetting about the existence of a misplaced gift card or store credit available. In other words, using the system website, mobile device (e.g., both “smart” and “dumb” mobile phone devices), a user may instantly check all balances of vendor-accepted funds or credits, gift card balances, rewards points balances, frequent flyer miles, etc., for a myriad of different, non-affiliated vendors using a common shared platform. This may advantageously obviate the need for a user to call the number on the back of each gift card to check a balance on each card. Some embodiments may also obviate the need for a user to individually visit each website of the myriad of different, non-affiliated vendors—each of which may request a new unique membership or login ID and password. According to some embodiments a user of the system may simply logon to the system website, and enter a card number and a mobile device number to access account balances information. Or, the user may simply keep the feed of mobile/SMS/MMS text messages sent to the user's phone, and scroll through the feed to find a redemption option.

Alternatively, a user may text the “check balances code” from their mobile device to a system-provided number to receive a displayed string, list, or array of available redemption options associated with the user's unique system card.

Some of the disclosed embodiments of the systems, methods, and apparatus may provide a convenient, fully automated, system-integrated way to purchase, renew, charge, transfer, redeem, send, and/or share. Some embodiments may serve as a multi-functional platform for supporting functions, promotions, and offers from a variety of vendors or entities, social networks, and/or third parties. Some embodiments may allow retailers to expand consumer audiences, share a single global universal point of sale, capitalize on a broad network of hosting/client locations, and/or engage users on a level not experienced to date. Users of a system, according to some embodiments, may agree to a single terms of use agreement or conditions of use of the system on the front end (e.g., privacy, etc.), and participating vendors/entities, financial institutions, social media sites, and advertising solutions may access user information in accordance with those single terms of use agreement or conditions of use on the back end, simplifying a number of interactions between consumers and individual vendors/entities and/or providing a secure gateway to personal transaction and correspondence information.

As will be appreciated from this disclosure, according to some embodiments, there may not be a need to have a checking account; and/or potentially expose thousands of dollars contained within a checking account, to make token purchases. Moreover, there may not be a need to fill out a new account profile with new vendors or entities for every online transaction.

According to some embodiments, users may make purchases with a single text message without the need to download a myriad of proprietary third-party applications, or the need to have a complicated smart phone or carry an expensive data plan.

According to some embodiments, users may electronically deliver amounts of funds/credits or pre-paid (or paid upon redemption, similar to cash-on-delivery “COD”) items, products, goods, or services with as little as a single text message, without the need to download a myriad of proprietary third-party applications, or the need to have a complicated smart phone or carry an expensive data plan.

Aspects of some embodiments may be conveniently integrated with existing more complex applications and infrastructures, for example, with Wal-Mart's “Scan & Go” Beta smart phone app, without limitation. For example, upon checkout, a user may scan items without actually receiving the goods scanned. Upon checkout, the user may enter a recipient's phone number or email address. A digital shopping list representative of the scanned items may be sent to the desired recipient(s) and paid for by the user. Payment may be via conventional cash, check, money order, credit card, debit card, or payment provider (e.g., PayPal), or may utilize a system-specific pre-paid card that maybe purchased and/or reloaded online, or at brick-and-mortar retail facilities.

While certain embodiments may often be described herein with references to a card-dispensing self-service kiosk and vendor participation system, an application to which embodiments may be advantageously suited, it will be readily apparent that all embodiments should not limited to those particular applications. For example, kiosks may be employed or otherwise utilized to manufacture and/or distribute a wide variety of articles including, but not limited to, physical or digital currency, tickets, passes, coupons, and other forms of purchasing media used by consumers and accepted by various vendors/entities. Moreover, many of the methods described herein may be performed using a computer or mobile device via a system application or system website without necessarily requiring access to a self-service kiosk.

Self-service kiosk apparatus may provide purchase recommendations based on an intended recipient's location with significantly more convenience than internet-based gift card exchange services and/or brick-and-mortar display racks which do not convey information about a vendor's geographic locations. Accordingly, instances maybe avoided where an end user or recipient of a gift card cannot effectively utilize the card due to a lack of vendor locations in their geographic region. Moreover, with some embodiments, smaller local vendors may be able to easily expand their market by increasing their exposure to more potential customers in new geographical regions. Some embodiments may also be advantageous because they may involve providing purchase recommendations based on recent user purchases within the system, or system-external user profiles and networks. For example, users of the system may set up “wish lists” or “favorites” in their own profile making it easier for other users to identify the perfect gift, or shopping list, or users of the system may wish to link third-party accounts such as social networking profiles with the system, making it easy to auto-populate user information and/or select appropriate gifting and personal products using aggregate marketing data.

Unlike the display racks found in brick-and-mortar stores, some embodiments may not require or consume significant physical retail space.

Unlike the display racks found in brick-and-mortar stores, some embodiments may employ low operating costs because no heating or air conditioning may be required; for example, for the card dispensing self-service kiosk apparatus described. Some preferred embodiments may also consume a relatively low level of electrical energy. According to some embodiments, card dispensing self-service kiosk apparatus described herein may have low maintenance costs and/or low downtime.

Furthermore, the card dispensing self-service kiosk apparatus disclosed herein may be situated in otherwise untraditional venues or locations such as outdoor areas (e.g., gas stations, rest stops, or outlets) and non-conventional points of sale. Where necessary, the card dispensing self-service kiosk apparatus may include heating and/or air conditioning units to accommodate less temperate climates.

The self-service kiosk apparatus disclosed may address the shortcomings of traditional brick-and-mortar and online gift card retail systems in a convenient and cost effective delivery vehicle having the added bonus of serving as an effective promotional platform that drives incremental sales to hosting locations. In addition, self-service kiosk apparatuses described herein may overcome the aforementioned disadvantages by at least offering more vendor/entity choices, credit amounts, and types of funds and credits. According to some embodiments, self-service kiosk apparatuses may provide the ability to sort participating vendors by alphabetic name, industry, product type, image/logo, credit or fund type, or other categorization, thereby serving to improve and facilitate customer experiences, and more logically and conveniently identify an appropriate product to purchase.

Some embodiments may advantageously not require an on-site store manager or customer service representative to facilitate purchases and/or redemptions of gift cards. Some embodiments may not require stocking personnel in order to frequently inventory, monitor, and/or re-supply a large number of deactivated stock gift cards which are displayed for purchase. Moreover, some embodiments may obviate the need for a checkout clerk and/or register, because in some preferred instances, many or all of the operational decisions maybe made or managed at a centralized location (e.g., system website) by a management team and servers located remote from the hosting locations.

Some embodiments may also provide a new vehicle for vendors to more effectively spend their advertising dollars without much waste or environmental impact. For example, vendors may spend more advertising dollars for higher levels of visibility to a user of the system when a user of the system visits the system website or logs in to one of their local system kiosks. By accessing the system database, vendors may, according to some embodiments, monitor how their promotions are being used, and by whom.

User profiles and account information may provide vendors with information about who is actually purchasing their products, products relating to their products, or competitive products to more accurately target their target market base, while also preventing the adverse affects of extreme couponing, mass advertising, paper refuge, and expensive productions.

Some embodiments may allow a user to facilitate their shopping and/or gift-purchasing experiences, create shopping or gift-giving lists on a user account supported by a system website, and/or facilitate locating a particular product or offering provided at a brick-and-mortar facility of a participating vendor/entity (e.g., using one or more system-integrated mobile applications on a user mobile device).

Some embodiments may also expand the number of gifting options for purchasers of gift cards, allowing more customized gifting solutions. Furthermore, some embodiments may allow a recipient to choose a closer, more convenient location to purchase their favorite goods and/or services. Moreover, some embodiments may provide means for corporations to better track popularity and market interest in certain product lines from a single system, rather than from a myriad of market analysis solutions. Furthermore, some embodiments may provide means for a user of the system to transfer their points, such as rewards points, frequent diner points, club points, membership points, loyalty points etc., to a single card, for example, by scanning into a kiosk, each card (or by entering each respective membership card number into their system account via a system website). Moreover, some embodiments may provide means for a user of the system to transfer their own points, such as rewards points, frequent diner points, club points, membership points, loyalty points etc., for one particular unrelated vendor/entity for funds or credits that are recognized or otherwise accepted as a form of payment to a second unrelated vendor/entity. Moreover, some embodiments may provide means for a first user of the system to transfer their own points, such as rewards points, frequent diner points, club points, membership points, loyalty points etc. earned, to a second user in various combinations, allocations, and amounts. Additionally, some embodiments may provide means for a user of the system to convert their own points, such as rewards points, frequent diner points, club points, membership points, loyalty points etc. earned, to another form of funds or credits such as currency (physical or digital/virtual), gift certificates or gift certificate credit, coupons or coupon credit, gift cards or gift card credit, tickets or ticket credit, passes or pass credit, stocks/funds or credit for purchasing stocks/funds, vouchers or voucher credit, prepaid minutes or credit for purchasing prepaid minutes, credit card credits, a check to the user or a credit to be applied to a check for the user in the future, etc.

Certain embodiments may allow subscribing users to quickly and readily access remaining balances or rewards balances to large numbers of participating vendors using a system-based application, thereby motivating a user to shop and to not forget about the existence of a misplaced gift card or store credit. For example, using the system website, mobile device (e.g., phone, tablet)-compatible app, a system-integrated kiosk, or the like, a user may be able to instantly check all balances of vendor-accepted funds or credits, gift card balances, rewards points balances, frequent flyer miles, etc., for a myriad of different, non-affiliated vendors using a common shared platform. This may advantageously obviate the need for a user to call the number on the back of each gift card to check a balance on each card. Embodiments may also obviate the need for a user to individually visit each website of the myriad of different, non-affiliated vendors—each of which may request a membership or login ID and password. A user of the system may simply logon to their system account via the system website, kiosk, or mobile app.

Some embodiments of the card dispensing self-service kiosk apparatus may provide a convenient, fully automated, system-integrated card production, purchasing, issuance, renewal, transfer, redemption, and/or redeeming system which may serve as a multifunctional platform for a variety of vendors or entities to share a single point of sale, capitalize on a broad network of hosting locations, and engage users on an equal level. Users of the system may agree to a single terms of use agreement or conditions of use of the system on the front end (e.g., privacy, etc.), and participating vendors/entities, financial institutions, social media sites, and advertising solutions may access user information in accordance with that single terms of use agreement or conditions of use on the back end, simplifying a number of interactions between consumers and individual vendors/entities.

According to some embodiments, a customer may conveniently electronically gift an item for another recipient during a normal everyday transaction, for instance, at checkout, when paying for other items needed by the customer.

According to some embodiments, a customer may electronically gift an item for another recipient, for instance, while physically shopping in a brick and mortar facility or online for other items needed by the customer.

According to some embodiments, a customer may electronically notify others (such as contacts, relatives, and friends) that they like or otherwise have a favorable opinion of an item during normal everyday activities, for instance, the electronic notification may occur while physically shopping in a brick and mortar facility, online, or when passing by a display.

According to some embodiments, a customer may electronically notify others, such as contacts, relatives, and friends, that they recommend an item during normal everyday activities, for instance, while physically shopping in a brick and mortar facility, online, or when passing by a display.

According to some embodiments, a customer may electronically purchase an item for him/herself or for another recipient while shopping online using the customer's mobile device.

Some embodiments may address the shortcomings of traditional gift card and eGift certificate retail and redemption in a convenient and cost-effective delivery vehicle having the added bonus of serving as an effective promotional platform that drives incremental sales through small purchases and word-of-mouth sharing between contacts, relatives, and friends.

Some embodiments may also provide a new vehicle for vendors to more effectively spend their advertising dollars by increasing the probability of spontaneous/instantaneous sales due to convenience to the consumer.

According to some embodiments, a customer may electronically gift an item for another recipient, for instance, while physically shopping in a brick and mortar facility, while reading a magazine, while listening to the radio, while watching TV, while passing by a billboard, while reading a vehicle wrap, while driving behind a semi-truck trailer having indicia thereon, while reading an internet advertisement, while shopping online, and the like.

According to some embodiments, a user may log into his/her online account utilizing his/her mobile phone and/or card information which may not be affiliated with a financial institution, bank, creditor, or lender.

According to some embodiments, a user may checkout for items, products, goods, or services ordered online utilizing his/her mobile phone and/or card information which may not be affiliated with a financial institution, bank, creditor, or lender.

According to some embodiments, a user may purchase, or electronically gift an item, or electronically receive or send a coupon or store credit.

According to some embodiments, a user may purchase for themselves, and/or purchase and electronically gift an item, product, good, or service, store credit, or other purchasable, electronically, online, using system credit which is associated with the user's electronic address. According to some embodiments, the system credit may be associated with the user's electronic address in a number of different manners described in any of the abovementioned co-pending applications, for instance, by paying cash at a register, by purchasing a system prepaid/gift card, by linking funds with a third-party financial institution account (e.g., bank account, credit card, payment service, or the like), and/or by purchasing system credit online. According to some embodiments, the system credit may be applied at a checkout page to complete the transaction. According to some embodiments, the transaction may be completed by making various communications between one or more of the participating vendor/entity's website containing the checkout page, the system, and the user.

According to some embodiments, funds or credit may also be simultaneously deducted from the system user's system account balance upon, prior to, or during the transaction (e.g., upon, prior to, or during certain transaction step executions).

According to some embodiments, a user may purchase, and physically gift and/or send an item found online, or at a kiosk, vending machine, or other internet-connected device intended for commerce, without necessarily entering credit/banking card information online, or necessarily providing credit/banking card information to the respective website, kiosk, vending machine, or other internet-connected device intended for commerce.

According to some embodiments, a user may purchase, and electronically gift and/or send an item, product, good, or service, using email, social media, or a mobile device, thereby obviating the need to provide sensitive financial information and/or personal information to an online retailer/merchant/vendor/selling entity, directly, or indirectly, via a checkout page.

According to some embodiments, a user may purchase for themselves, and/or purchase and electronically gift an item, product, good, or service, or electronically receive or send a coupon or store credit. For example, according to some embodiments, a user may purchase for themselves, and/or purchase and electronically gift an item, product, good, or service, or electronically receive or send a coupon or store credit, or system credit, to a vanity address associated with a single individual or entity, in a single communication. The vanity address may comprise one or more electronic addresses of the single individual or entity. Funds or credit may also be simultaneously deducted from the system user's system account balance, in a multiple of one (for the single individual or entity).

According to some embodiments, a user may purchase for themselves, and/or purchase and electronically gift an item, product, good, or service, or electronically receive or send a coupon or store credit, or system credit, to a vanity address associated with multiple individuals or entities, in a single communication. Funds or credit may also be simultaneously deducted from the system user's system account balance, in a multiple matching the number of multiple individuals or entities associated with the vanity address.

According to some embodiments, a system user may link one or more of their own electronic addresses with a vanity address (e.g., system “screen name” or “profile identifier”) which has not already been taken by another system user, for themselves, allowing other system users to purchase and electronically gift an item, product, good, or service, or electronically send a coupon, store credit, or system credit, to the system user's vanity address in a single communication, wherein each of the linked one or more of the system user's electronic addresses are delivered with, and receive, similar redemption information and/or transaction information upon system receipt of the single communication made by the other system users, and wherein the system user and/or the other system users making the single communication may receive an electronic receipt containing transaction information upon system receipt of the single communication.

According to some embodiments, a system user may link one or more electronic addresses of others (e.g., friends, contacts, family members, coworkers, etc.) with a ‘group’ vanity address, allowing the system user to purchase and electronically gift an item, product, good, or service, or electronically send a coupon, store credit, or system credit, to the vanity address in a single communication, wherein each of the others associated with (i.e., “linked” with) the ‘group’ vanity address may receive similar redemption information and/or transaction information via each of the linked electronic addresses affiliated with the ‘group’ vanity address, upon system receipt of the single communication by the system user, and wherein the system user may receive an electronic receipt containing transaction information upon system receipt of the single communication. Funds or credit may also be simultaneously deducted from the system user's system account balance, for example, in a multiple of the number of others associated with the ‘group’ vanity address (e.g., the number of electronic addresses “linked” to the created ‘group’ vanity address. For example, if 5 electronic addresses (e.g., screen names, profile ID's, handles, email addresses, phone numbers, etc.) which correspond to five different individuals are linked to a ‘group’ vanity address by the system user, and the vanity address is used in a system transaction, the system may deduct the cost of the sent item, product, good, or service, or sent coupon, store credit, or system credit, times 5, from the system user's system account balance).

According to some embodiments, a user may purchase, and physically gift and/or send an item purchased online, without entering credit card information online.

According to some embodiments, a user may purchase, and physically gift and/or send an item found online, or in a brick and mortar store, without necessarily entering credit/banking card information online, or necessarily providing credit/banking card information to the brick and mortar store.

According to some embodiments, a user may purchase, and physically gift and/or send an item purchased online, without entering recipient address information online.

According to some embodiments, a user may purchase, and physically gift and/or send an item found online, or in a brick and mortar store, without necessarily entering recipient address information online, or necessarily providing recipient information to the brick and mortar store.

According to some embodiments, a user may purchase, and physically gift and/or send an item purchased online, using email, social media, or a mobile device, thereby obviating the need to provide sensitive financial information and/or personal information to the retailer/merchant/vendor/selling entity directly.

According to some embodiments, a user may purchase, and electronically gift and/or send an item, product, good, or service, using email, social media, or a mobile device, thereby obviating the need to provide sensitive financial information and/or personal information to the retailer/merchant/vendor/selling entity, for example, providing sensitive financial information and/or personal information to the retailer/merchant/vendor/selling entity directly, or indirectly.

According to some embodiments, users may apply funds or system credits to one or more electronic address (e.g., email address, mobile phone number, social media handle/profile ID number, screen name, etc.), for example, simply by sending one or more communications (e.g., an SMS message, MMS message, social media message/post, phone call, or email) to a system. According to some embodiments, the one or more communications may each involve less than 30 characters (or, in the case of a phone call, as little as 1 or 2 keypad entries or two spoken strings or words), and even as little as 10 characters or less, depending on the character string length of the item code associated with the product, item, good, or service being sent and/or the character string length of the recipient(s) electronic address(es) or system vanity address assigned to the recipient(s) electronic address(es).

According to some embodiments, users may apply funds or system credits to any electronic address (e.g., email address, mobile phone number, social media handle/profile ID number, screen name, etc., simply by walking up to a kiosk or point of sale, requesting an amount of system credit to be purchased, providing an electronic address, and paying for the requested amount of system credit (corresponding to the amount of system credit to be purchased) normally. The kiosk or point of sale employee may apply system credit to the provided electronic address at the completion of the transaction.

For example, according to some embodiments, a user may walk up to a payment terminal, ask the employee for system credit (e.g., “ . . . and I'd like to add $40.00 USD worth of send1 credit to my phone 8015548634, so please just add it to my order” or “I'd like to purchase $25 USD worth of send1 credit to email address JohnDoe@email.com”), then pay for it as if it were an item for purchase (e.g., by cash, credit, gift card, voucher, coupon, debit, mobile payment, cryptocurrency, etc.), and then the employee places one or more inputs into computer hardware and/or executable software, in order to electronically associate the amount of requested and paid for funds to the electronic address provided (e.g., if a mobile number is provided, e.g., 8015548634, and $15 CAD is provided at a point of sale, then $15 CAD worth of system credit may be applied to the mobile number 8015548634.).

According to some embodiments, consumers may purchase system credit, and/or redeem items, or cash out credit (which may require certain transactional fees to the system and/or the vendor/merchant/selling entity trading system credit for actual currency (e.g., at a predetermined rate, such as X % cash back to the user in exchange for 100% system credit, without limitation)).

According to some embodiments, only a fixed “per transaction” fee may be required, instead of a “%-based” fee or “%-based” fee plus a transaction fee. In other words, if a customer uses the system to make a purchase (whether a $1.00 item, or a $100.00 item, or a $1000.00 item), a fixed dollar “per-transaction” fee (e.g., $0.25 or “$X”) may be all that is required, wherein no “percentage” fee may be applied. In this regard, both merchants, and customers, may enjoy system benefits.

According to some embodiments, a user of the system, with system credit associated with their electronic address, may shop online (e.g., via a website or mobile application), engage (whether tactile, operative, physical, or virtual) an icon, widget, link, icon, word, image, system logo, or the like, which is provided adjacent an interesting product, item, good, or service. The product, item, good, or service may be displayed on a browser, page, window, or the like, and may comprise a price, identifying information, a description, or the like. The product, item, good, or service may be redeemable/purchasable in a brick-and-mortar facility, online (e.g., an electronic product which may be delivered electronically, e.g., via streaming or download), or, the product, item, good, and/or service may be available for purchase and physical delivery to the purchaser or another user other than the purchaser. The user of the system may purchase and electronically or physically deliver the product, item, good, or service using one of a number of various methods. The one of a number of various methods may include providing one or more electronic or physical addresses online (e.g., via a website or mobile application pop-up, window, or page). One or more instructions may be sent to the user (and/or intended recipient) on a different platform associated with the one or one or more electronic or physical addresses provided.

According to some embodiments, transactions, and/or one or more steps thereof, may be performed by, exclusively by, or may be performed using any one or more of a mobile messaging application communication, an SMS/MMS communication, an electronic mail communication, a web-based fillable form-based entry and submission, a phone call (using keypad entries or verbal commands to an automated attendant), one or more inputs or replies to public or private (e.g., “direct”) messaging, one or more inputs or replies to public or private social media posts, one or more inputs to a “top-of-the-box” system (e.g., using voice command or controller and menu input), input to a gaming device having network access, input to an onboard vehicle computer (using impromptu or on-demand keypad entries, touch screen entries, verbal commands, or pressing a “buy”, “send”, “like”, or “command” button on a steering wheel, dashboard location, or console location, for instance while in close proximity to a location-based paper or electronic/digital billboard, without limitation). In some non-limiting embodiments, such communications may be made, for example, via integrated home or integrated car system or Bluetooth-enabled or other wireless phone technology available or known in the art which is configured to integrate a separate mobile device with a vehicle, without limitation.

According to some embodiments, transactions may be made between platforms, such as between different platforms; for example, an email-based transaction request, which may include one or more mobile phone numbers, social media profile addresses, email addresses, and/or physical addresses of one or more recipients in the email, along with one or more items to be sent and/or amount of credit to be sent to each of the one or more mobile phone numbers, social media profile addresses, email addresses, an/or physical addresses of one or more recipients. According to some embodiments, redemption information may be sent to the one or more mobile phone numbers, social media profile addresses, email addresses, and/or physical addresses of one or more recipients. According to some embodiments, downloadable items, products, goods, or services, and/or information pertaining thereto, may also be delivered to the one or more mobile phone numbers, social media profile addresses, email addresses, and/or physical addresses of one or more recipients. According to some embodiments, physical items may be sent to the one or more physical addresses of the one or more recipients, if provided, for example, provided in advance or upon request by the system (e.g., via one or more secondary prompts for data entry), and the one or more items, products, gifts, or services are appropriate for delivery. According to some embodiments, the redemption information, and/or downloadable items, products, goods, or services, may be delivered to a web-based platform, such as a social media account, system account, system website (with verification/user authentication e.g., a one-time password texted, emailed, “Tweeted”, or delivered via mobile messaging (e.g., Facebook messenger)), or third party platform or account (e.g., Amazon.com, Overstock.com) accessible by the recipient(s) via the internet/cloud/network.

According to some embodiments, transactions may be made between platforms; for example, a web-based transaction request, which may include one or more mobile phone numbers, social media profile addresses, email addresses, and/or physical addresses of one or more recipients in the web-based transaction, along with one or more items to be sent and/or amount of credit to be sent to each of the one or more mobile phone numbers, social media profile addresses, email addresses, and/or physical addresses of one or more recipients.

According to some embodiments, transactions may be made between platforms; for example, a web-based transaction request, which may involve one or more mobile phone numbers, social media profile addresses, email addresses, and/or physical addresses of a user in the web-based transaction, along with one or more items to be sent, one or more generated unique transaction codes, one or more generated unique validation codes, a user's system card number, a user's system PIN number, a one-time code delivered to the user via the system on a platform other than which the web-based transaction is made, and/or information pertaining to a total cost of the transaction.

According to some embodiments, if the user's physical address (e.g., mailing or shipping address) has been associated with or otherwise “linked” with the one or more mobile phone numbers, social media profile addresses, email addresses involved with the transaction, a user may not need to re-provide the information in order for the transaction to be made. According to some embodiments, if a recipient's physical address (e.g., mailing or shipping address) has been associated with or otherwise “linked” with the one or more mobile phone numbers, social media profile addresses, email addresses involved with the transaction, a user may not need to provide the recipient information in order for the transaction to be made.

Redemption information may be sent to the one or more mobile phone numbers, social media profile addresses, email addresses, and/or physical addresses of one or more recipients. Downloadable items, products, goods, or services, and/or information pertaining thereto, may also be delivered to the one or more mobile phone numbers, social media profile addresses, email addresses, and/or physical addresses of one or more recipients. Physical items may be sent to the one or more physical addresses of the one or more recipients, if provided, and the one or more items, products, gifts, or services are appropriate for delivery. The redemption information, and/or downloadable items, products, goods, or services, may also be delivered to a web-based platform, such as a social media account, system account, or third party platform or account (e.g., Amazon.com), accessible by the recipient(s) via the internet/cloud/network.

Redemption or receipt information may be sent to the one or more mobile phone numbers, social media profile addresses, email addresses, and/or physical addresses of one or more recipients associated with the transaction.

According to some embodiments, transactions may be made between platforms; for example, a phone call-based transaction request, which may include one or more mobile phone numbers, social media profile addresses, email addresses, and/or physical addresses of one or more recipients in the web-based transaction, along with one or more items to be sent and/or amount of credit to be sent to each of the one or more mobile phone numbers, social media profile addresses, email addresses, and/or physical addresses of one or more recipients. Redemption information may be sent to the one or more mobile phone numbers, social media profile addresses, email addresses, and/or physical addresses of one or more recipients. Downloadable items, products, goods, or services, and/or information pertaining thereto, may also be delivered to the one or more mobile phone numbers, social media profile addresses, email addresses, and/or physical addresses of one or more recipients. Physical items may be sent to the one or more physical addresses of the one or more recipients, if provided, and the one or more items, products, gifts, or services are appropriate for delivery. The redemption information, and/or downloadable items, products, goods, or services, may also be delivered to a web-based platform, such as a social media account, system account, or third party platform or account (e.g., Amazon.com), accessible by the recipient(s) via the internet/cloud/network.

According to some embodiments, transactions may be made between platforms; for example, a mobile device (e.g., mobile messaging, SMS, or MMS)-based transaction request, which may include one or more mobile phone numbers, social media profile addresses, email addresses, and/or physical addresses of one or more recipients in the web-based transaction, along with one or more items to be sent and/or amount of credit to be sent to each of the one or more mobile phone numbers, social media profile addresses, email addresses, and/or physical addresses of one or more recipients. Redemption information may be sent to the one or more mobile phone numbers, social media profile addresses, email addresses, and/or physical addresses of one or more recipients. Downloadable items, products, goods, or services, and/or information pertaining thereto, may also be delivered to the one or more mobile phone numbers, social media profile addresses, email addresses, and/or physical addresses of one or more recipients. Physical items may be sent to the one or more physical addresses of the one or more recipients, if provided, and the one or more items, products, gifts, or services are appropriate for delivery. The redemption information, and/or downloadable items, products, goods, or services, may also be delivered to a web-based platform, such as a social media account, system account, or third party platform or account (e.g., Amazon.com), accessible by the recipient(s) via the internet/cloud/network.

According to some embodiments, transactions may be made between platforms; for example, a social media-based transaction request, which may include one or more mobile phone numbers, social media profile addresses, email addresses, and/or physical addresses of one or more recipients in the web-based transaction, along with one or more items to be sent and/or amount of credit to be sent to each of the one or more mobile phone numbers, social media profile addresses, email addresses, and/or physical addresses of one or more recipients. Redemption information may be sent to the one or more mobile phone numbers, social media profile addresses, email addresses, and/or physical addresses of one or more recipients. Downloadable items, products, goods, or services, and/or information pertaining thereto, may also be delivered to the one or more mobile phone numbers, social media profile addresses, email addresses, and/or physical addresses of one or more recipients. Physical items may be sent to the one or more physical addresses of the one or more recipients, if provided, and the one or more items, products, gifts, or services are appropriate for delivery. The redemption information, and/or downloadable items, products, goods, or services, may also be delivered to a web-based platform, such as a social media account, system account, or third party platform or account (e.g., Amazon.com), accessible by the recipient(s) via the internet/cloud/network.

According to some embodiments, transaction requests may include prompting the system to provide one or more one-time verification codes or passwords.

According to some embodiments, transaction requests may include prompting the system to provide one or more one-time verification codes or passwords, the system sending/delivering one or more one-time verification codes, unique validation codes, unique transaction codes, or passwords, and the user providing the sent/delivered one or more one-time verification codes, unique validation codes, unique transaction codes, or passwords.

According to some embodiments, upon a successful transaction request, the system may deduct a credit amount from a user's system account credit balance, and credit a participating vendor/entity's system account credit balance.

According to some embodiments, transaction requests may deduct a credit amount balance from the requester's account credit balance; and/or deliver an amount of credit and/or number of items to a recipient, in the same transaction request.

According to some embodiments, transaction requests may be made in as few as 100 characters or less. In some embodiments, transaction requests may be made in as few as 50 characters or less. In some embodiments, transaction requests may be made in as few as 40 characters or less. In some embodiments, transaction requests may be made in as few as 30 characters or less. In some embodiments, transaction requests may be made in as few as 20 characters or less. In some embodiments, transaction requests may be made in as few as 15 characters or less. In some embodiments, transaction requests may be made in as few as 10 characters or less.

In some embodiments, transaction requests may be made in as much as 10 characters.

In some embodiments, transaction requests may be made in as much as 15 characters. In some embodiments, transaction requests may be made in as much as 20 characters. In some embodiments, transaction requests may be made in as much as 30 characters. In some embodiments, transaction requests may be made in as much as 40 characters. In some embodiments, transaction requests may be made in as much as 50 characters.

In some embodiments, recipient information may be obtained (e.g., imported, accessed, or copied and pasted) from various platforms, including, but not limited to: phone-stored contacts, contacts stored online or in the “cloud” (e.g., a social media platform like Facebook, Twitter, LinkedIn, YouTube, Google+), email platforms (e.g., Hush-mail, Gmail, Yahoo, MSN, Hotmail, or other email client).

In some embodiments, recipient information may be obtained (e.g., imported, accessed, or copied and pasted) from various platforms, including, but not limited to: phone-stored contacts, contacts stored online or in the “cloud” (e.g., a social media platform like Facebook, Twitter, LinkedIn, YouTube, Google+), email platforms (e.g., Hush-mail, Gmail, Yahoo, MSN, Hotmail, AOL, or other email client, such as a webmail client).

According to some embodiments, visual-based, image-based, scannable, and/or machine-readable indicia may be generated by the system, provided by the system, and/or stored by the system. The visual-based, image-based, scannable, and/or machine-readable indicia may also be electronically or physically delivered to a recipient. The visual-based, image-based, scannable, and/or machine-readable indicia may also be electronically or physically delivered to one or more recipients and/or to the user requesting a transaction to be made involving the one or more recipients. The indicia may be generated using scripts (e.g., such as software classes available or downloadable from BarcodePHP.com, without limitation). The indicia may be delivered by any of the platforms mentioned herein, and/or may be displayed on peripherals, such as billboards, signs, displays, television, movies, literature, advertisements, paper goods (e.g., receipts or product packaging/labeling means), and the like.

In some embodiments, advantages may include one or more of the following: increasing incremental sales, new customers for vendors, ability to donate in a few seconds/characters, ability to sign up/register for events and pay in a few seconds/characters, the ability to gift pool or send corporate gifts to all employees within a company with the ease of a single email, the ability to keep a universal portable registry that others may see/view with ease, the ability to send, gift, buy, redeem, pay, or send money in a few seconds/characters, the ability to take advantage of ubiquitous and mature technologies such as email, text, phone, and barcodes, which everyone may be able to understand and perform, the ability to buy, gift, fund, top-off, or replenish a system account using only cash (or, in the case of some embodiments, by linking their system account with a third party prepaid, bank, or credit card account such as VISA, AMEX, MasterCard, Discover, PayPal, and the like), the ability to buy, gift, fund, top-off, or replenish a system account using multiple platforms (web or in-store purchase), the ability to buy, gift, fund, top-off, or replenish a system account using multiple currencies (including crypto-currencies), the ability to have an account created and set up for someone instantaneously; for example, upon receipt of a redemption, the ability for the system and method of a platform to go viral—spreading to users and creating user accounts for non-user recipients automatically, the ability to perform mobile transactions without expensive mobile billing or linking sensitive personal financial information such as bank account, credit card, and or social security information, the ability to conveniently pay for online items using your phone, fairly/practically anonymously, without needing to deal with fluctuating and risky crypto-currencies such as Bitcoin and/or without necessarily providing vendors with annoying amounts of personal information/credentials, the ability to click on a system widget or icon and pull down a list of friends, family, and/or contacts to send the adjacent item to (when surfing websites while logged into a system-affiliated plug-in), and various combinations and variations thereof.

In some embodiments, all or some of the platform commands and/or transaction particulars described herein and co-pending applications may be practiced with SMS/MMS messaging alternatives, such as applications (e.g., Snapchat, Twitter, WhatsApp, Facebook messenger, etc.).

In some embodiments, ordering and/or sending for delivery of purchased or redeemed items may be facilitated with a text, email, phone-call, web-submission, or social media post or interaction. Delivery may be made, in some embodiments, to the requesting user. In some embodiments, delivery may be made to one or more persons which are not the requesting user. Imagine being able to pay for, and deliver a snack or gift to several of your friends with a single Tweet or SMS message—without necessarily having to type in everyone's electronic address (after “linking” them to a ‘group’ vanity address such as “friends”)?! In some embodiments, the system platform may process such transactions to make gifting extremely easy and simple.

In some embodiments, items may be traded for cash or system credit with, or without penalty. In some embodiments, items may be traded for other items with, or without penalty. In some embodiments, items may be traded for other items with, or without additional credits being debited from a user's system account balance. In some embodiments, greater value items may be traded for other lesser value items with, or without additional credits being added/deposited to a user's system account balance. In some embodiments, a “trade” command or the like may be used, in conjunction with an item code to be traded for, and a valid unused redemption code which is to be traded for the item code. Differences (both positive and negative differences) in price between the redemption code and item code may be performed automatically by the system. In some embodiments, a “cash” command or the like may be used, in conjunction with: an item code to be traded for, and/or a valid unused redemption code which is to be traded for; wherein a value of the item code to be traded for and/or the valid unused redemption code to be traded for may be converted to system credit which may be used for other purchases, gifts, or donations (with or without penalty).

According to some embodiments, the system may be used as a personal banking system, piggy bank, or “slush fund for fun”, and may be used to make small purchases online or to local vendors without using a credit card, debit card, or bank card which could be compromised by a lack of security measures imposed by the online or local vendors.

In some embodiments, funds may be maintained by the system, and/or a third-party financial institution, organization, corporation, or the like, which is affiliated with the system.

In some embodiments, funds, system functions, software, hardware, code, programs, databases, and/or algorithms, may be maintained by the system, and/or a third-party financial institution, organization, corporation, or the like, which is affiliated with the system—including, but not limited to, third party servers, hosting solutions/providers, telecommunications gateways, etc.

In some embodiments, a portion of transactions or system credit purchased may be gifted and/or otherwise donated to a charitable organization. For example, in some embodiments, 0.1% through 10% or more of the value of each transaction may go to a charitable cause. In some embodiments, redemptions for free and/or prepaid redemption codes may be affiliated with charitable organizations. In some embodiments, vendors or merchants (whether brick and mortar or online-based) may provide item codes which are free to use and share, just use, just share, and/or redeem, without cost—or with cost in exchange for a donation made to a third party organization.

In some embodiments, users may opt-in to non-system supported SMS mobile marketing promotions by using a system command (e.g., “like”) in combination with a vendor's name, trade name, trademark, brand, or corporation/entity name. In such embodiments, it may be possible for vendors or merchants to allow the system (e.g., send1) to host their mobile marketing operations (in such cases, an “opt out” option may be included with each of such communication to system users). In some embodiments, some or all information conducted or held by the system may be kept private and not be sold to corporations. In some embodiments, some or all information conducted or held by the system may be sold, monetized, or provided at no charge to participating entities at the system's own discretion. In some embodiments, as for social media-based transaction requests, some transaction requests to the system may be made public. Redemption information sent by the system in response to such public transaction requests may be kept private by direct messaging (person-to-person).

According to some embodiments, certain participating vendors/selling entities which cooperate with the system in any capacity or function may enjoy/share in royalties, discounts, or profits made by or received by the system.

According to some embodiments, such transactions may be performed by voice command.

According to some embodiments, such transactions may be performed using input means, such as a graphical user interface (GUI), navigable menu(s), input field(s), fillable web form(s), programmable or non-programmable button(s) or button(s) sequence(s) (e.g., controller buttons, remote controller buttons, steering wheel buttons, cellular phone buttons, touchpad/touch screen buttons, keyboard button, terminal buttons, keypad buttons, and/or the like).

According to some embodiments, such transactions may be performed through an internet TV system by voice command.

According to some embodiments, such transactions may be performed through an internet, cable, or satellite-based TV or radio/music system by voice command.

According to some embodiments, such transactions may be performed through an internet TV system by controller button(s) and menu navigation.

According to some embodiments, such transactions may be performed through an internet, cable, or satellite-based TV or radio/music system by controller button(s) and menu navigation.

According to some embodiments, such transactions may be performed through a mobile application, vehicle system (e.g., connected car), or intelligent assistant (e.g., Microsoft's Cortana, Apple's Siri) by voice command.

According to some embodiments, such transactions may be performed through a mobile application by voice command.

According to some embodiments, such transactions may be performed through a mobile application by menu navigation, fillable forms, touchpad/touch screen interactions, motions/movements/accelerations, programmable motions/movements/accelerations using accelerometer or mercury switch-enabled hardware devices, physical or electronically-displayed button(s), or the like.

According to some embodiments, such transactions may be performed through a vehicle GUI, navigation system, GPS, command center, voice texting system, or integrated hands-free (e.g., Bluetooth phone) system, by voice command. For example, using one or more installable system software modules or system-offered API's may be utilized to make system transactions through a connected car system (e.g., Nissan Connect) which may comprise any one or more of a head-unit, an infotainment unit, an in-dash system with a screen from which the operations of the connections may be seen or managed by the driver, a music/audio playing device and/or software, a smart phone app, a smart phone integration device such as connection hardware (e.g., USB cable) or wireless connection protocol (e.g., Bluetooth), navigational equipment and/or software, roadside assistance equipment and/or software, voice command equipment and/or software, contextual help/offer devices and/or associated software, parking apps, engine controls and car diagnosis software and/or hardware, etc.

According to some embodiments, such transactions may be performed through a vehicle GUI, navigation system, GPS, or integrated hands-free (e.g., Bluetooth device-enabled phone) system, by controller button(s) and/or menu navigation (for example, to cycle through a list of phone contacts—whether on a mobile device or CPU hard drive, cloud storage, or available on a mobile device via linking a third party account (e.g., LinkedIn, Twitter, Facebook, Google+, Gmail, Yahoo, etc.) using an application/third party website login, or API.

According to some embodiments, such transactions may be performed by voice command or one or more physical inputs to a computer (e.g., desktop, laptop, tablet, box-top cable system, satellite receiver system, wearable computer, virtual reality system, headset, gaming device, etc.) while running a system-integrated application, system website, system-integrated browser, system-integrated plug-in or add-on, or third party website that is integrated with the system.

According to some embodiments, redemptions, such as system credit, store/gift/vendor/merchant/selling entity-recognized credit, or a pre-paid voucher information (physical or electronic) may be used in part, wherein remaining portions may be provided with a cash value (which may comprise a percentage of system credit value), credit vouchers (e.g., gift card, gift certificate, store credit), or a new system redemption code for the remaining portions.

According to some embodiments, banks, credit card companies, financial institutions, or organizations which are affiliated with a money card, debit card, electronic benefits transfer card, rewards card, or credit card, may integrate system functions with their own proprietary systems, platforms, and member accounts, and/or may practice system functions, methods, steps, and transactions independently of the system platform. In this regard, system credit would essentially be funds associated with a user's account and/or card number of the banks, credit card companies, financial institutions, or organizations.

According to some embodiments, a system API may be offered to third parties, such as online merchants, electronic commerce apps and websites (e.g., Amazon.com, Overstock.com, EBAY, Walmart.com, Target.com, etc.), delivery or service-based products (e.g., Groupon, Uber, GrubHub), payment services or clients (e.g., AMEX, VISA, DISCOVER, MASTERCARD, PayPal, Bitcoin), and social network services (e.g. Twitter, LinkedIn, Google+, Yahoo, Facebook), etc. to enable seamless integrations and transactions between users or for a user in converting various types of funds to system credit, and vice-versa. Alternatively, third-party API's may be integrated with the system to enable seamless integrations and transactions between users or for a user to “send all or a select few of their Twitter followers a burger using item code (RedRobinBurger)”, or “sign all or some of their Facebook friends up for a 5 k race for a charity using item code (MudRunSLC)”, or “send all of their LinkedIn connections a promotional item, or holiday season gift”, or “send all nieces and nephews in contacts list 5 dollars worth of Chuck e Cheese arcade credits with item code (ChuckE5)”, or “send mom and dad each a 20 dollar gift card to Target via Will-Call pickup at store using item code (Target20)”, or “send your long lost friend the new Radiohead CD or iTunes album using item code (RadioheadNewRelease)”, or “send all of your coworkers 3 free months of Netflix using item code (Netflix3)”, or “send your sports fan friend a free pay-per-view of the game using an item code (GameDay14237)”, or “send your Google+ circle tickets to a show or event using item code (BBQfest2014Entry)”, or “send your mountain biking and climbing partners each a Cliff bar using item code (CLIFF1) or the 12-digit GTIN barcode number for the Cliff bar flavor of the sender's choice”. The number of possibilities using the system platform is endless. The item codes may be created or otherwise given meaning from existing tags, such as Twitter hashtags, without limitation. The recipient electronic addresses may be manually entered for each transaction, or the electronic addresses may be associated with a system vanity address (e.g., “@billsmith145” could be linked to a vanity address “bill”, or all three of “@amysue14”, “JoshClemmons@gmail.com”, and “7035548634” could be linked to a vanity address “coworkers”; wherein a user may only need to send the system a communication comprising the text “friends Netflix3” to pay for and electronically or physically deliver “@amysue14”, “JoshClemmons@gmail.com”, and “7035548634” 3 free months of prepaid Netflix subscription; or, wherein a user may only need to send the system a communication comprising the text “MudRunSLC bill” to sign “@billsmith145” up for a charity 5 k race via the system and Twitter).

Social application integration of all kinds is anticipated, without limitation. For example, Facebook likes, Google+ likes, or Twitter “re-tweets” may be digested and imported to system databases and tables to build system data non-organically. For example, system-integrated software may allow a user to link their system account with their social network and subsequently allow the user to “import” their likes list (e.g., from Facebook). In some instances, system users may simply like an item by sending a command to the system indicating that they wish to like something or add it to their wish list, along with information pertaining to the respective item, product, good, or service.

While not shown, pull-down menus and/or tick boxes may be employed in system applications and/or web forms to allow users to sign into their account and send items from a list of their system-stored friends/relatives/contacts. The pull-down menus and/or tick boxes may also be purposed to allow a user to enter multiple user email addresses, mobile device numbers, handles, user IDs, other electronic addresses, or physical addresses. The pull-down menus and/or tick boxes may also be purposed to allow a user to enter multiple items, recipients, and/or amounts (e.g., 4 items and an amount of system credit to be sent to one or more individuals, such as pre-confirmed system “buddies”).

Various protocols may be put into place to allow a user to securely link their email address with an existing system mobile account. Conversely, protocols may also be put into place to allow a user to securely link their mobile account with an existing system email account. Protocols may also be put into place to allow a user to simultaneously securely subscribe their email address and mobile account with the system for multiple platform capability. Protocols may also be put into place to allow a user to securely subscribe their third-party usernames, ID numbers, handles, extensions, or aliases with the system for multiple platform capability. These protocols may incorporate any protocols known in the art, or the proprietary protocols which will be appreciated from this disclosure and the disclosure of the prior or co-pending related applications to which this disclosure claims the benefit of.

According to some embodiments, a secure connection, such as HTTPS protocol may be utilized. Such secure connections may obviate the need to utilize secure tokens, keys, PINs, passwords, pass codes, pass phrases, or the like.

According to some embodiments, the system may provide an advantageous platform as an internet-based lottery. For example, users may purchase an item code which identifies a particular lottery pool (e.g., item code ‘YuppieVegasPool343’) or system credits may be sent to a lottery-organizing system user (e.g., YuppieVegasPool343@hotmail.com). Each time the item code is purchased using the system (or an amount of system credits are sent to the lottery-organizing system user's electronic address), the purchasing user may secure another entry into the pool. The requesting user may receive a ticket number in the form of an encrypted redemption code which may or may not contain embedded information pertaining to the electronic address the request was made (e.g., area code or last four characters of an email address may be scrambled and embedded into the electronic ticket number(s) or information provided to the purchaser). Internet-based lottery tickets may be purchased by others and gifted to a recipient, wherein one or more portions of the recipient's electronic address information may be embedded into an electronic ticket number and sent to the recipient. After a predetermined amount of time, a user in the pool may be selected. A portion of the proceeds may go to the system and/or a charity of the system's choice. Alternatively, or in addition to this, a portion of the proceeds may go to seeding a bigger internet-based lottery pool (e.g., one which may have a different item code or user electronic address). The system may be configured to select a guaranteed winner from the “participants” database table, or the system may be configured for users to enter a pick of numbers, and the system may generate a random set of numbers, and the generated numbers may be compared with user submissions to determine a winner.

It should be understood that all system components methods discussed herein are preferably integrated with a system application which may be written for various proprietary hardware (e.g., Android app available on Google play, Apple app store app, etc.). The app may receive transaction information and be integrated with the system database and tables therein so as to retrieve and store data and facilitate communications to system users and parties (both system parties and third party non-affiliated parties) which might be affected by a particular transaction.

According to some embodiments, while the working embodiment code examples shown below primarily utilize mobile phone numbers and email addresses as an electronic address or system “account” identifier, it should be clearly understood that other electronic addresses may be utilized. For instance, if the code utilized a Twitter API, a user may be able to enter a number of Twitter user addresses (e.g., @joey45) or hashtags (e.g., #stjude) to identify a recipient and/or allow the system to locate a recipient or sending user account. Alternatively, if the code utilized a Facebook API, a user may be able to enter a number of Facebook screen names or Facebook user ID numbers to identify a recipient and/or allow the system to locate a recipient or sending user account. It should be understood that the database MySQL tables and their respective columns and data shown in this application, any application to which this application claims priority to, and/or existing co-pending applications, are merely exemplary in nature, and such examples given are in no way intended to limit the expansive scope of inventive aspects discussed herein. Moreover, while the SMS code provided in may be optimized to send an item or amount of credit to a single recipient, it should be readily appreciated that one or more of a plethora of parsing algorithms may be instituted, wherein the parsing algorithm may be designed to scan through a command in a communication, such as a text-based communication, to identify, verify address information of, and/or iteratively extract multiple recipient addresses into an array which may then be exploded and used to send multiple recipients in a single transaction and update respective system database tables, without limitation. For example, instead of “8014452934 2.00” to send the recipient having a mobile device number of 8014452934, 2 dollars worth of system credit, the user may use the system command “8014452934 4104923745 9082847138 2.00” to send 2.00 to each of the recipients having mobile device numbers 8014452934, 4104923745, and 9082847138. Or, the user may ‘link’ all of the aforementioned numbers (i.e., “electronic addresses”) to a single vanity code (e.g., “group 8014452934 4104923745 9082847138 usergroup1”), using a system “link” command (or the like) and instead, send the system command “usergroup1 2.00” to send 2.00 worth of system prepaid credit to each of the recipients having the mobile device numbers 8014452934, 4104923745, and 9082847138 (e.g., via text messaging).

A user may provide the following SMS commands to a system long code or short code to perform various functions. Typing “PEEK 7033183424” may display what a person having the number 7033183424 likes. In some embodiments (and as may be appreciated from the code of certain preferred embodiments), the requesting user may need to first be “friends” or “system buddies” to be able to conduct such espionage. In some embodiments, as shown in the code, 7033183424 may be notified that someone is peeking at their system likes or “portable and universal wish list”. The wish list may contain item barcode information such as a number of 12-digit GTIN codes which may be looked up from a number of various internet websites to identify the product (e.g., GS1). Ideally, the system database may be heavily populated with a large number of commercially-available items which would make ideal gifts—whether micro- or token-gifts (e.g., candy bar or toy for niece and nephew), or larger, more expensive gifts (e.g., power tools for dad). In some embodiments, the command “Join” may be used before a recipient phone number or email address to initiate a friend or system buddy request. A user may use the command “Group” and then a desired name of the group before listing a set of mobile device numbers and/or email addresses to create a “shorthand” list of contacts (e.g., “sportsfriends”, “family”, “coworkers”). In this regard, a user may very quickly send the entire group an item or credit without necessarily spelling out each address each time. For example, an SMS-based system request may resemble “sportsfriends 5.00” which would send all recipients affiliated with group “sportsfriends” 5.00 of system credit. Alternatively, an SMS-based system request may resemble “family bigmac” which would send all recipients affiliated with group family, a unique redemption code(s), barcode image(s), PIN(s), or password(s) good for a McDonald's Big Mac sandwich at a system-participating McDonald's location.

While not expressly shown, phone call-based system transactions may similarly allow a system user to send one or more items or system credit to one or more recipients. Using a navigable menu and keypad entries, and/or voice-enabled commands via an automated attendant powered by voice recognition/interpretation software, a system user may simply say or enter one or more item codes and/or one or more recipient electronic addresses. Keypad number equivalents of item codes may utilized, and possible matches may be reiterated with one or more choices to select. For email addresses, a user may enter ‘*’(star key) in lieu of: ‘@’ (at sign) or ‘.’ (period/decimal point) or an ‘&’ (ampersand). In some instances, multiple sequential entries of ‘*’ (star key) may be made to indicate different characters. For example, in a non-limiting exemplary embodiment, a single ‘*’ (star key) may indicate a ‘.’ (period/decimal point), two sequential star keys (‘**’) may indicate an ‘@’ (at sign).

A command to the system such as “B”, “Bal”, or “Balance” may be interpreted as an instruction to reply back to the requesting user with their current system balance.

System buddy requests may require replying with one-time confirmation codes. Alternatively, while not shown, a user password, passphrase, or PIN may be created by the user and sent to the system and stored in a system database, wherein the user password, passphrase, or PIN may be required in every system transaction. In some embodiments, the user password, passphrase, or PIN may be may be generated by the system, stored in a system database, and then sent to a user who might use it to complete each transaction.

According to some embodiments, an “order” or “send” feature may be employed, where a user may type the command “order” or “send” and then a redemption code or item code. The system may void the transaction, contact a third party (e.g., Amazon.com or GrubHub) and send the information via an integrated API. In this regard, a user may use the system to redeem the option, and a non-system third party may complete the order and delivery of the respective item associated with the transaction. For instance, a user may type “send hotnreadypep” to a system long code, short code, or email address, or say “send hotnreadypep” to a system phone number provided with an automated attendant, or enter a number equivalent to hotnreadypep to a keypad of a phone during a call to a system phone number. The system may deduct system credit from the requesting user's system account, and may then export the information to a third party database and/or send a communication via a network (e.g., satellite, internet, and/or cellular network) to the closest delivery facility which contains the order information. The third party may then contact the user to obtain their location for delivery or to ask for particular order preferences (e.g., flavorings, toppings, colors, sizes, models, etc.). A user having a redemption code that was pre-purchased or received from another system user or participant may similarly communicate a “send” or “order” command and include the redemption code and/or associated PIN, password, or the like in combination the “send” or “order” command. In this regard, credits may not necessarily be deducted, but rather, a valid or active unused redemption may be used and voided and the item, product, good, or service be delivered or otherwise provided to the requesting user.

While not particularly shown in this application or otherwise provided in code examples shown in the aforementioned priority applications to this application, a “List” command may be incorporated with the system, wherein a user may obtain a list of all of their used and/or unused redemptions. The information may contain codes, PINs, item prices, vendor information, item options, redemption options, etc. The information may be communicated back to the requesting user on any platform discussed in this application and/or applications to which this application claims priority, but is primarily communicated back to the requesting user using the same platform which was used to make the request. For example, a user may type the word “List” in a command to an SMS-enabled system short code or long code and the system may reply with a message listing all unused redemptions. As suggested in working code examples contained herein or in the aforementioned priority applications, a user with too many “redemptions” may easily re-gift a redemption so that it may be thought of as a “gift that keeps on giving”.

According to some embodiments, reusable or one-time PINs or passwords may be incorporated into any request or command made to the system (on any one or more of the system-supported platforms) as a security measure and to prevent fraudulent transactions attempted through spoofing of phone numbers, email addresses, Twitter handles, Facebook IDs, etc. The reusable or one-time PINs or passwords may be incorporated into any request or command made by any platform/protocol disclosed (e.g., phone call, SMS or MMS text messaging protocol, mobile messaging application or service, social media platform, web-based submission, web-based online fillable field, or the like.

According to some embodiments, buy something for yourself, while in a store, using your system credit, by entering your own phone number, and the UPC code, SKU#, or item code of a product, item, good, or service for sale in the store. Instantly receive a redemption code for the product, item, good, or service, from the system, via your phone. Then, use the redemption code at the counter to redeem the product, item, good, or service, without necessarily needing to provide other means of payment (and, in some instances, taxes, as the item was purchased “online”).

According to some embodiments, buy something for another, while in a store, using your system credit, by entering the recipient's phone number, and UPC code, SKU#, or item code of a product, item, good, or service for sale in the store. Instantly deliver a redemption code for the product, item, good, or service, to the recipient, from the system, via your phone. Then, the recipient may walk into a store (same franchise or unaffiliated store carrying the same product), look for the product, item, good, or service, and use the redemption code at the counter to redeem the product, item, good, or service, without necessarily needing to provide other means of payment (and, in some instances, taxes, as the item was purchased “online”).

According to some embodiments, a user may buy something for another person (i.e., a recipient), while they are in a store; for example, using their system credit, by entering the recipient's phone number, and UPC code, SKU#, or item code of a product, item, good, or service for sale in the store. According to some embodiments, a user may instantly deliver a redemption code for the product, item, good, or service, to the recipient, from the system, via their phone.

According to some embodiments, a person could text message another individual, or message the individual in some other manner (e.g., phone call, email, or social post), and the person may say that he/she is shopping and wants “UPC#012345678910”. The individual receiving the message from the person may remotely use their system credit by texting the person's mobile address, along with the requested UPC# (e.g., “7034029811 012345678910”, or “7034029811 012345678910”, or “7034029811,012345678910”, or “012345678910,7034029811”). Accordingly, in some embodiments, it may be possible to, in a single text, be debited for the transaction, wherein the redemption information may be sent to the person.

According to some embodiments, there is no need to create an account, as one is automatically created upon asking for credit, providing an electronic address to send the credit, and paying for credit. This may be done at any participating store.

According to some embodiments, no physical prepaid system cards may be necessary. Participating stores may carry a mobile device (e.g., cell phone) having SMS capability, an email client, Twitter, or other mobile messaging platform readily available, and have pre-purchased system credit already affiliated with a phone number, email address, or Twitter profile/handle/address. In other words, the participating store may have purchased system credit from the system, in advance, for example, through a system vendor use/sales/distributor agreement. When a user wants to join the system and/or add credit to their electronic address, they simply ask the participating store to add credit to their desired electronic address, and then pay for it normally. The participating store may use the mobile device to send some of their own pre-paid credit to the requesting user, in exchange for payment from the user. In some embodiments, payment may be of any form (cash, debit, credit, coupon, gift card, cryptocurrency, or the like). Alternatively, the participating store may download system software or purchase separate system hardware to work similar functions.

According to some embodiments, a participating vendor may use one or more SMS, email, or social media communications to the system to check the validity/status of a redemption code, and redeem a redemption code through the system. Some inconsequential information about the redeeming user may or may not be required, depending on whether it is preferred that redemption information is transferable or not, or for added security and fraud prevention.

According to some embodiments, no special hardware other than a phone or computer with internet connection is necessary. The system may be configured to instantly credit the participating store's electronic address immediately, as soon as a redemption code claim is made by a user. At any time, the participating store may ask the system to provide cash, money order, check, direct deposit, wire, or electronic funds transfer, in exchange for their system credit balance (e.g., in accordance with terms and conditions set forth in a user agreement). Or, a claim code may be delivered to the redeeming user upon a redemption/void attempt being made by another user for a particular redemption code. In some embodiments, it may be necessary for the redeeming user to provide the received claim code to the participating store trying to redeem the redemption code. In this regard, fraudulent activity on the participating store's behalf may be mitigated. The participating store may send the claim code in a communication to the system to instantly receive system credit for the product, item, good, or service being redeemed.

According to some embodiments, participating stores may see increased incremental sales, foot traffic, and the like, by offering system services, performing system functions, accepting and selling system credit, and providing system functionalities.

According to some embodiments, a user may be able to purchase something for themselves, or for another individual, without entering personal banking or credit card information online, and/or without entering detailed information regarding name, address, etc.

According to some embodiments, a user may receive account information which may be used immediately to make purchases and/or redeem items, products, goods, or services, without having to sign up, register online, or provide personal information such as one or more of the following, without limitation: bank information, credit card information, address information, and the like.

According to some embodiments, machine-readable indicia may be provided to a recipient which may be used as a virtual payment card, virtual loyalty card, virtual gift card, virtual pre-paid voucher card, virtual rewards card, virtual membership card, or the like. The machine-readable indicia may be received via a system mobile application, third-party mobile application affiliated with the system, or via MMS text message from the system or system affiliate or system partner. The machine-readable indicia may be generated by a system mobile application, or third-party mobile application affiliated with the system. The machine-readable indicia may be encrypted, received by a payment terminal via scanning, and decrypted by the system or third-party affiliated with the system. In some embodiments, the same machine-readable indicia may be used during every transaction to redeem received and/or pre-purchased items, products, goods, and services, and a new machine-readable indicia may be periodically requested and provided to the user, for increased security.

According to some embodiments, a request for new account and/or PIN information may be communicated to the system, from a user, wherein the system may generate new account and/or PIN information (which may or may not have been compromised) and the system may instantly deliver it, electronically, to the requesting user. The new account and/or PIN information may comprise machine-readable indicia information.

A user's physical address information may be linked to a system account or electronic address on file with the system, via an electronic communication to the system, thereby avoiding the need to provide it each time at an online checkout page. This also goes for a recipient system user. A recipient user's physical address information may be linked to a system account or electronic address on file with the system, making the transaction easier for a person trying to physically send or deliver something to a recipient.

According to some embodiments, a user may redeem one or more (e.g., multiple) items, products, goods, or services associated with the user's electronic address (e.g., mobile phone number), and/or user's system-affiliated card, which may comprise a system card, or a third-party card such as a loyalty card, rewards card, gift card, credit card, debit card, bank card, prepaid card, or the like.

According to some embodiments, a user may utilize account information which to immediately redeem pre-purchased or received pre-paid items, products, goods, or services, without having to sign up, register online, or provide personal information such as one or more of the following, without limitation: bank information, credit card information, address information, and the like.

According to some embodiments, a system mobile application, or third-party mobile application affiliated with the system may be loaded onto an NFC-compatible mobile device of a user, and may be used to redeem one or more pre-paid items, products, goods, or services associated with the user (e.g., received gifts from other system users). The system mobile application, or third-party mobile application may be used by a user, as the user's virtual payment card, virtual loyalty card, virtual gift card, virtual pre-paid voucher card, virtual rewards card, virtual membership card, or the like, and to redeem pre-paid items, products, goods, or services associated with the user's electronic address and received via the system. In this regard, a user merely needs to place their mobile device proximate to a payment terminal to quickly identify redemption information associated with the user. The near-field communications may be encrypted, and decrypted by the payment terminal via system software or API.

According to some embodiments, a request for PIN information, such as a one-time alphanumeric PIN or QR code may be communicated to the system, upon entry of a phone number or electronic address to a payment terminal, for example, upon redemption. The system may generate new PIN information and the system may instantly deliver it, electronically, to the respective user performing a “redemption” of one or more items, products, goods, or services. The PIN information may comprise machine-readable indicia information which may be delivered via MMS messaging or mobile app.

A list of a user's prepaid redemption information may be linked to the user's system card or third-party card which is affiliated with the system. Or, a list of user redemption information may be linked to a system account or electronic address on file with the system.

Accordingly, the advantages of embodiments are not limited only to those advantages described herein; and a plethora of other features advantages are provided by, will be readily apparent from, or may be appreciated from: the foregoing disclosure, the following description, the accompanying drawings, co-pending related applications, and/or prior applications to which this disclosure may claim the benefit of.

### BRIEF SUMMARY OF EMBODIMENTS

According to some embodiments, a method of sending funds or credits is disclosed. The method may comprise the step of a third electronic address receiving a first electronic communication from a first electronic address. The first electronic communication may comprise the third electronic address, the first electronic communication may comprise a second electronic address, the first electronic communication may comprise a first instruction, the third electronic address may be different from the first electronic address, and the third electronic address may be different from the second electronic address. The method may comprise the step of software, for example, server-side scripts, parsing the first electronic communication. The method may comprise the step of software, for example, server-side scripts, processing the first instruction utilizing the first electronic address and the second electronic address. The method may comprise delivering, via software, a second electronic communication to the second electronic address, wherein the second electronic communication may comprise first data pertaining to the first instruction. In some embodiments, the first data pertaining to the first instruction may comprise first transfer amount information, wherein the first transfer amount information may comprise a first amount of funds to be transferred from a first account (associated with the first electronic address) to a second account (associated with the second electronic address). The method may comprise one or more of the following steps: accessing (via software), a database containing the first account associated with the first electronic address, determining first account balance information associated with the first account, comparing the first account balance information with the first transfer amount information, and determining if the first account balance information is sufficient to comply with the first instruction; wherein the step of delivering a second electronic communication to the second electronic address may be performed if the first account balance information is sufficient to comply with the first instruction. In some embodiments, the first instruction may comprise the first transfer amount information.

According to some embodiments, the first data pertaining to the first instruction may comprise first redemption information having a first redemption information value, wherein the first redemption information may comprise a first code which may be configured to be exchanged for at least one of: a first item, a first product, a first good, and a first service. According to some embodiments, the first code may comprise at least one of: a machine-readable image, a machine-displayable image, a machine-readable sound, a machine-interpretable sound, and a character string. According to some embodiments, the first code further may comprise at least one second code, wherein the at least one second code may comprise at least one of: a machine-readable image, a machine-displayable image, a machine-readable sound, a machine-interpretable sound, and a character string.

According to some embodiments, the first redemption information may comprise first redemption amount information pertaining to the first redemption information value, wherein the first redemption amount information may comprise a first amount of funds to be debited from a first account associated with the first electronic address, as a condition of software complying with the first instruction.

to some embodiments, the method may comprise one or more of the following steps: accessing a database containing the first account associated with the first electronic address (via software), retrieving first account balance information associated with the first account, comparing the first account balance information with the first redemption amount information, and determining if the first account balance information is sufficient to comply with the first instruction. According to some embodiments, the step of delivering a second electronic communication to the second electronic address may be performed if the first account balance information is sufficient to comply with the first instruction.

According to some embodiments, the first instruction may comprise an item code, wherein the item code may comprise a character string, and wherein the character string may comprise at least one of the group consisting of: a GTIN number, a UPC number, an SKU number, a trademark, and a description; wherein the description may comprise a string of characters which is representative of the first item, the first product, the first good, and the first service.

According to some embodiments, the step of a third electronic address receiving a first electronic communication from a first electronic address may comprise the third electronic address receiving the first electronic communication from the first electronic address via a first platform comprising a first communication protocol; wherein the step of delivering a second electronic communication to the second electronic address via software may comprise delivering the second electronic communication to the second electronic address via a second platform comprising a second communication protocol; wherein the first communication protocol may be different from the second communication protocol, and/or the first platform may be different from the second platform.

According to some embodiments, the first platform may comprise an environment selected from one of the group consisting of: an email-based environment, a web-based environment, an application-based environment, a mobile messaging application-based environment, a short message service (SMS)-based environment, a multimedia message service (MMS)-based environment, a telephonic-based environment, and a social media-based environment; and wherein the second platform may comprise an environment selected from one of the group consisting of: an email-based environment, a web-based environment, an application-based environment, a mobile messaging application-based environment, a short message service (SMS)-based environment, a multimedia message service (MMS)-based environment, a telephonic communication-based environment, and a social media-based environment.

According to some embodiments, the first electronic address may comprise an electronic address selected from one of the group consisting of: an email address configured to be used within an email-based environment, a GUID configured to be used within a web-based or application-based environment, an IP address configured to be used within a web-based or application-based environment, a screen name configured to be used within a web-based or application-based environment, a phone number configured to be used within a telecommunications-based environment, and a social media screen name configured to be used within a social media-based environment. According to some embodiments, the second electronic address may comprise an electronic address selected from one of the group consisting of: an email address configured to be used within an email-based environment, a GUID configured to be used within a web-based or application-based environment, an IP address configured to be used within a web-based or application-based environment, a screen name configured to be used within a web-based or application-based environment, a phone number configured to be used within telecommunications-based environment, and a social media screen name configured to be used within a social media-based environment;

According to some embodiments, the first electronic communication may be selected from one of the group consisting of: an electronic mail message, a web-based submission, an application-based submission, a mobile messaging application electronic message, a short message service (SMS) electronic message, a multimedia message service (MMS) electronic message, a wireless phone call, a landline phone call, an instant message, an electronic forum message, and a social media post. According to some embodiments, and wherein the second electronic communication may comprise at least one of the group consisting of: an electronic mail message, a web page link, an application-based alert, a mobile messaging application electronic message, a short message service (SMS) electronic message, a multimedia message service (MMS) electronic message, a phone call, a voicemail, a landline phone call, an instant message, an electronic forum private inbox message, a direct messaging (DM) electronic message, a PUSH-based message, and a social media post.

According to some embodiments, the first electronic communication may comprise a fourth electronic address. In such embodiments, the method may comprise the step of processing, via software, the first instruction utilizing the fourth electronic address and/or the method may comprise the step of delivering, via software, a third electronic communication to the fourth electronic address. According to some embodiments, the third electronic communication may contain second data pertaining to the first instruction.

According to some embodiments, the first instruction may comprise transfer amount information, wherein the transfer amount information may comprise an amount of funds to be transferred from a first account associated with the first electronic address to a second account associated with the second electronic address. The transfer amount information may also comprise an amount of funds to be transferred from the first account associated with the first electronic address to a third account associated with the fourth electronic address. In such embodiments, the method may further comprise the steps of: determining a total amount of funds to be debited from a first account associated with the first electronic address; accessing a database containing the first account associated with the first electronic address; debiting the first account associated with the first electronic address by the total amount of funds to be debited; optionally creating a second account associated with the second electronic address if the second account associated with the second electronic address does not exist; optionally creating a third account associated with the fourth electronic address if the third account associated with the fourth electronic address does not exist; crediting the second account associated with the second electronic address by the amount of funds to be transferred (from a first account associated with the first electronic address to a second account associated with the second electronic address); and, crediting the third account associated with the fourth electronic address by the amount of funds to be transferred (from a first account associated with the first electronic address to a second account associated with the second electronic address).

According to some embodiments, the second electronic address may be different than the fourth electronic address. According to some embodiments, the second electronic address may be a different type of electronic address than the fourth electronic address.

According to some embodiments, the first instruction may comprise an item code associated with redemption information having a redemption information value, wherein the item code may comprise an item code purchase cost. In such embodiments, the method may further comprise one or more of the following steps: determining a total amount of funds to be debited from a first account associated with the first electronic address; accessing a database containing the first account associated with the first electronic address; debiting the first account associated with the first electronic address by the total amount of funds to be debited; crediting a second account associated with the second electronic address with redemption information; crediting a third account associated with the fourth electronic address with redemption information; optionally creating a second account associated with the second electronic address if the second account associated with the second electronic address does not exist; optionally creating a third account associated with the fourth electronic address if the third account associated with the fourth electronic address does not exist.

According to some embodiments, the first data pertaining to the first instruction may comprise first redemption information relating to the item code, and the first redemption information may be configured to be exchanged for at least one of the group consisting of: a first item, a first product, a first good, and a first service. According to some embodiments, the second data pertaining to the first instruction may comprise second redemption information relating to the item code, and the second redemption information may be configured to be exchanged for the at least one of the group consisting of: a first item, a first product, a first good, and a first service.

According to some embodiments, the second electronic address may be different than the fourth electronic address. According to some embodiments, the second electronic address may comprise a first type of electronic address, and the third electronic address may comprise a second type of electronic address, wherein the first type may be different from the second type.

According to some embodiments, the step of delivering a second electronic communication to the second electronic address via software may comprise delivering the second electronic communication to the second electronic address using a second platform comprising a second communication protocol; wherein the step of delivering a third electronic communication to the fourth electronic address may comprise delivering the third electronic communication to the fourth electronic address using a third platform comprising a third communication protocol; and wherein the second communication protocol may be different from the third communication protocol, or the second platform may be different from the third platform.

According to some embodiments, a self-service kiosk apparatus is disclosed. The self-service kiosk apparatus may be configured for providing immediately usable funds or credits to a second user from a first user without necessarily involving additional human interaction between the first and second users. According to some embodiments, the self-service kiosk apparatus may comprise one or more of the following: a CPU; internet and/or network connection means for accessing a system server; and, a user interface configured to allow the second user to interact with the self-service kiosk apparatus to receive or transfer information regarding the funds or credits provided by the first user to the second user. According to some embodiments, the self-service kiosk apparatus may be provided with means for immediately providing to the second user, at least a portion of the funds or credits, the portion of the funds or credits being immediately usable by the second user in one of many manners. According to some embodiments, the self-service kiosk apparatus may comprise storage means for containing one or more card blanks. According to some embodiments, the self-service kiosk apparatus may comprise means for producing a card for the second user, wherein the card produced for the second user may be selected from the one or more card blanks which may be configured to be contained or contained within in the storage means. According to some embodiments, the self-service kiosk apparatus may comprise digital write means, wherein the card produced for the second user may be configured to be loaded with information pertaining to the funds or credits by the digital write means prior to or after the second user receives the card. According to some embodiments, the card produced for the second user may also be configured to be customized with one or more unique features. According to some embodiments, the one or more unique features may comprise image card image information obtained from image data. According to some embodiments, the image information may be selected from one or more of the group consisting of: a message, a design, a stock image, a user name, a 1-D barcode, a 2-D barcode, a data matrix code, a QR code, an image, a graphic, printed matter, text, an alphanumeric code, a photo, a logo, indicia, a brand, trade dress, a trademark, user data, a color, a puzzle, a visual game, and word art. According to some embodiments, the self-service kiosk apparatus may comprise printing means. The printing means may be configured to print image data onto the one or more card blanks, wherein the one or more card blanks are configured to be printed on using the printing means. According to some embodiments, the printing means may be configured to print and deliver to the second user, an article selected from one or more of the following group: a ticket, a pass, a coupon, a redemption code, a gift card, a voucher, a lottery ticket, a pawn or loan ticket, a receipt, a greeting card, a credit card, a pre-paid minutes card, a check, and postage. According to some embodiments, the self-service kiosk apparatus may be configured to dispense a card containing the information regarding the funds or credits to the first user so as to enable the first user to personally deliver the card to the second user. According to some embodiments, the self-service kiosk apparatus may be configured to be conveniently placed in a venue or location which may include outdoor venues or locations. According to some embodiments, the self-service kiosk apparatus may comprise payment receiving means which incorporates one or more of the items selected from the group consisting of: software, hardware, physical apparatus for accepting payments, a bill receiving device, a bill identification system, a coin receiving device, a coin identification system, an electronic funds transfer acceptance system, a currency acceptance mechanism, a credit card acceptance system, a coupon code validation system, a gift card validation system, an EFT-POS terminal, a magnetic stripe reader, an EMV/VSDC/Mchip/AEIPS/Jsmart/D-PAS acceptance terminal, a secure online payment submission web page, a secure checkout page, a digital wallet acceptance terminal, a digital currency exchange client, a contactless payment system, payment due calculating software, electronic payment software, electronic payment system, credit adjusting software, account information updating software, a payment application, a wireless smart phone swipe crediting system, a mobile device tap and go system, a tap and go sticker system, an NFC-compatible payment system, and a digital mobile device payment application, remote deposit (capture) software, Check 21 Act-compliant online deposit software, Check 21 Act-compliant direct deposit software, and mobile deposit software. According to some embodiments, the self-service kiosk apparatus may be configured to provide the portion of the funds or credits to the second user, regardless of the physical location of the first user. According to some embodiments, the self-service kiosk apparatus may be configured to provide the portion of the funds or credits to the second user in the absence of the physical presence of the first user, and/or when the first user is remotely located from the self-service kiosk apparatus and second user. According to some embodiments, the funds or credits are purchased by the first user via the internet or network using a device other than the self-service kiosk apparatus. According to some embodiments, the device other than the self-service kiosk apparatus may be selected from one or more of the group consisting of: another self-service kiosk apparatus, a mobile device, a PDA, a cell phone, a smart phone, a smart watch, a gaming device, a desktop computer, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the self-service kiosk apparatus may be configured to communicate with at least one other self-service kiosk apparatus via the internet or other network. According to some embodiments, the self-service kiosk apparatus may be configured to be accessed by the first user to provide the information regarding the funds or credits at a first point in time, and is configured to be accessed by the second user at a second point in time which is later than the first point in time, to receive or transfer the information regarding the funds or credits provided by the first user. According to some embodiments, the self-service kiosk apparatus may comprise means selected from one or more of the group consisting of: display means, image scanning means, image capture means, payment acceptance means, hardware link means, audio input means, security means, housing, power supply means, printing means, database access means, data input means, advertising means, reader means, receipt means, payment dispensing means, card production means, card dispensing means, greeting card production means, a system client, card storage means, data disk reader means, digital write means, and postage means. According to some embodiments, the information regarding funds or credits may comprise cryptocurrency. According to some embodiments, the self-service kiosk apparatus may be configured to convert information regarding fund or credits provided by the first user from cryptographic payment data to non-cryptographic payment data or type of funds or credits for receiving by the second user. According to some embodiments, the self-service kiosk apparatus may be configured to convert information regarding fund or credits provided by the first user from non-cryptographic payment data or type of funds or credits to cryptographic payment data for receiving by the second user.

A method of providing immediately usable funds or credits to a second user from a first user without necessarily involving additional human interaction between the first and second users is also disclosed. According to some embodiments, the method may comprise the following steps: providing a system comprising one or more of the following components: a system website, a system application, and at least one system kiosk which are configured to communicate with each other; the first user providing one or more customer inputs to a system component which includes information regarding funds or credits to be transferred to the second user; and, the second user receiving the information regarding funds or credits via a component of the system. According to some embodiments, the first user may provide the one or more customer inputs to a system kiosk. According to some embodiments, the second user may receive the information regarding funds or credits via a system kiosk. According to some embodiments, the method may comprise the step of the second user interacting with the system kiosk to receive or transfer the information regarding the funds or credits provided by the first user. According to some embodiments, the system kiosk may provide at least a portion of the funds or credits to the second user, wherein the at least a portion of the funds or credits are immediately usable by the second user in one of many manners. According to some embodiments, the method may comprise the system kiosk producing a card for the second user via card production means. According to some embodiments, the method may comprise the system kiosk moving a card blank from card storage means provided to the system kiosk for containing one or more card blanks, to the card production means. According to some embodiments, the method may comprise the second user immediately using the card produced for the second user by the system kiosk at a vendor or entity. According to some embodiments, the vendor or entity may comprise one or more of the following: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, or an entity offering private lessons. According to some embodiments, the method may comprise the second user immediately using the card without necessarily involving human interaction between the vendor or entity and the second user. According to some embodiments, the first user may provide the one or more customer inputs to the system application, and the second user may receive the funds or credits via the system application. According to some embodiments, the first user may provide the one or more customer inputs to the system website, and the second user may receive the funds or credits via the system application. According to some embodiments, the first user may provide the one or more customer inputs to the system application, and the second user may receive the funds or credits via the system website. According to some embodiments, the first user may provide the one or more customer inputs to the system application, and the second user may receive the information regarding funds or credits via the system kiosk. According to some embodiments, the first user may provide the one or more customer inputs to the system website, and the second user may receive the information regarding funds or credits via the system kiosk. According to some embodiments, the first user may provide the one or more customer inputs to the system website, and the second user may receive the information regarding funds or credits via the system website. According to some embodiments, the first user may provide the one or more customer inputs to the system website, and the second user may receive the information regarding funds or credits via a system kiosk. According to some embodiments, the first user may provide the one or more customer inputs to the system kiosk, and the second user may receive the information regarding funds or website. According to some embodiments, the first user may provide the one or more customer inputs to the system kiosk, and the second user may receive the information regarding funds or credits via the system website. According to some embodiments, the method may comprise the system kiosk loading the card with information pertaining to the funds or credits via digital write means prior to or after the second user receives the card from the system kiosk. According to some embodiments, the method may comprise the kiosk customizing the card with one or more unique features according to the one or more customer inputs provided by the first user. According to some embodiments, the one or more unique features may be selected from one or more of the group consisting of: a chip, an RFID device, alphanumeric text or characters, a barcode, a magnetic stripe, a solid state device, and image information. According to some embodiments, the one or more unique features may be selected from one or more of the group consisting of: an integrated circuit, a microprocessor, a security authentication device, a single sign-on SSO device, an EMV chip, an ISO/IEC 7816-compliant device, a contact-less “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8, 16, or 32-bit public key dynamic 8 k-1 MB EEPROM device with math coprocessor, a 125 kHz proximity read-only-compatible device, a 13.56 MHz ISO 14443 0.5-8 kB read/write-compatible device, a MiFare protocol-compatible device, a proprietary protocol device, an ultrahigh frequency gen 1 or ten 2 device, a semiconductor, a proximity locator chip, a ScenSor DW1000 chip by DecaWave, an IEEE 802.15.4a-compatible wireless communication device, an NFC-compatible chip, an antenna, an electromagnetic field detectable device, a tag, a transponder, a frequency modulating/de-modulating-compatible device, a passive reader active tag device, an active reader tag device, a battery-assisted tag (BAT) device, an electronic product code (EPC) containing device, a mobile computing communication device, a virtual badge device, a wireless tracking device, a UHF inlay, a smart label, an ultra strip III label, a theft prevention security tag, an electronic article surveillance (EAS) system-compatible tag, a 1D bar code, a 2D bar code, a data matrix code, a QR code, a product code, a UPC code, an ISO/IEC 15416-compliant marking, an ISO/IEC

15426-2-compliant marking, a SO/IEC 15415-compliant marking, a ISO/IEC TR 29158-compliant marking, text, characters, numbers, letters, printed indicia, embossed indicia, cryptotext, an alphanumeric code, a high-coercivity (HiCo) magnetic device, a low-coercivity (LoCo) device, a message, a design, a stock image, a user name, an image, printed matter, a photo, a logo, indicia, a brand, trade dress, a trademark, a graphic, user data, a color, a puzzle, a visual game, and word art. According to some embodiments, the method may comprise the kiosk printing one or more pieces of image information onto a card blank which is configured to be printed on. According to some embodiments, the step of the second user receiving the information regarding funds or credits via the system application system website, or system kiosk may comprise the second user receiving the information regarding funds or credits in the form of at least one of the group consisting of: cash, a ticket, a pass, a coupon, a redemption code, a gift card, a voucher, a lottery ticket, a pawn ticket, a loan ticket, stock or tradable fund, a credit card, pre-paid minutes, a check, customer loyalty points, miles points, frequent diner points, cryptographic currency, a credit to the second users credit card account, a credit to the second user's debit account, system account credit, a receipt, and postage. According to some embodiments, the one or more customer inputs which may include information regarding funds or credits to be transferred to the second user may comprise one or more of the group consisting of: image data, audio data, user data, purchase data, redemption data, and payment data. According to some embodiments, the step of the first user providing one or more customer inputs which includes information regarding funds or credits to be transferred to the second user may comprise providing payment data in the form of at least one of the group consisting of: a cash payment, a credit-based payment, a debit-based payment, a check-based payment, a points redemption-based payment, a gift card redemption-based payment, a voucher-based payment, a coupon-based payment, a redemption code-based payment, a system account credit-based payment, a cryptographic currency-based payment, and a traded fund-based payment. According to some embodiments, the method may comprise a component of the system determining a value of the payment data in its native unit value to define an input credit value. According to some embodiments, the method may comprise converting the input credit value to a first system-based credit value. According to some embodiments, the method may comprise validating or authenticating the value of the payment data in its native unit value using security means provided to components of the system. According to some embodiments, the method may comprise the first or second user selecting a redemption option associated with purchase data or redemption data, the redemption option having a native unit value. According to some embodiments, the method may comprise validating or authenticating the value of the redemption option in its native unit value using security means provided to components of the system. According to some embodiments, the method may comprise a component of the system defining an output credit value from the native unit value of the redemption option. According to some embodiments, the method may comprise a component of the system converting the output credit value to a second system-based credit value. According to some embodiments, the method may comprise a component of the system comparing the first system-based credit value with the second system-based credit value to determine a difference in system-based credit values. According to some embodiments, if the difference in system-based credit values is positive, the redemption option may be purchased by the first user or redeemed by the second user. According to some embodiments, if the difference in system-based credit values is negative, the redemption option may not be purchased by the first user or redeemed by the second user. According to some embodiments, system components may be configured to not present or otherwise show/display certain redemption options to the first or second users if the difference in system-based credit values is negative. According to some embodiments, the system website or the system application may be accessed by the first or second user using a computer or mobile device. According to some embodiments, the mobile device may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD).

A method of providing immediately usable funds or credits to a customer [91, 92] without necessarily involving additional human interaction with the customer [91, 92] is also disclosed. According to some embodiments, the method may comprise one or more of the following steps: providing a system comprising one or more of the following components: a system website [127], a system application [147], and a system kiosk [3] which are configured to communicate with each other; the customer [91, 92] providing one or more customer inputs [4] to a component [3,127, 147] of the system; the customer [91, 92] selecting at least one redemption option using the component [3,127, 147] of the system, the at least one redemption option having a native unit value; the customer [91, 92] selecting at least one form of payment data [10] to be used in exchange for the selected at least one redemption option; the component [3, 127, 147] of the system determining a value of the payment data [10] in its native unit value to define an input credit value; the component [3, 127, 147] of the system converting the input credit value to a first system-based credit value; the component [3, 127, 147] of the system defining an output credit value from the native unit value of the at least one redemption option; the component [3, 127, 147] of the system converting the output credit value to a second system-based credit value; the component [3, 127, 147] of the system comparing the first system-based credit value with the second system-based credit value to determine a difference in system-based credit values; and/or the component [3, 127, 147] of the system providing the at least one redemption option to the customer [91, 92] if the difference in system-based credit values is positive. According to some embodiments, the redemption option may be associated with purchase data [9] or redemption data [64]. According to some embodiments, the method may comprise validating or authenticating the value of the payment data [10] using security means [99] provided to the component [3, 127, 147] of the system. According to some embodiments, the method may comprise validating or authenticating the value of the at least one redemption option using security means [99] provided to the component [3,127, 147] of the system. According to some embodiments, if the difference in system-based credit values is negative, the at least one redemption option may not be provided to the customer [91, 92] or otherwise redeemed by the customer [91, 92]. According to some embodiments, the component [3, 127, 147] of the system may not present or otherwise show certain redemption options to the customer [91, 92] if the difference in system-based credit values is negative. According to some embodiments, the step of selecting at least one form of payment data [10] may comprise selecting a form of payment data [10] selected from one or more of the group consisting of: a cash payment [11], a credit-based payment [12], a debit-based payment [13], a check-based payment [14], a points redemption-based payment [78], a gift card redemption-based payment [15], a voucher-based payment, a coupon-based payment [16], a redemption code-based payment, a system account credit-based payment [17], a cryptographic currency-based payment [18], and a traded fund-based payment [81], a ticket-based payment [75], a pass-based payment [67], a coupon-based payment [16], a lottery-based payment [82], a pawn or loan ticket-based payment, a receipt-based payment [20], a pre-paid minutes-based payment [76], a check-based payment [14], and a postage-based payment [25]. According to some embodiments, the step of selecting at least one redemption option may comprise selecting at least one redemption option from the group consisting of: a cash redemption [11], a credit-based redemption [12], a credit to the customer's [91, 92] credit card account, a debit-based redemption [13], a credit to the customer's [91, 92] debit card account, a check-based redemption [14], a points-based redemption [78], a gift card redemption [15], a voucher redemption, a coupon-based redemption [16], code-based redemption, a system account credit-based redemption [17], a cryptographic currency-based redemption [18], a traded fund-based redemption [81], a ticket-based redemption [75], a pass-based redemption [67], a coupon-based redemption [16], a lottery-based redemption [82], a pawn or loan ticket-based redemption, a receipt-based redemption [20], a greeting card-based redemption [161], a pre-paid minutes-based redemption [76], a check-based redemption [14], and a postage-based redemption [25]. According to some embodiments, the method may comprise associating information pertaining to the at least one redemption option with a system profile [130] of the customer [91, 92]. According to some embodiments, the step of providing the redemption option to the customer [91, 92] may comprise updating [142] a system profile [130] of the customer [91, 92]. According to some embodiments, the step of providing the redemption option to the customer [91] may comprise delivering the redemption option to the customer [91] in an electronic form, wherein the redemption option may be immediately utilized by the customer [91] in the electronic form, saved for later use by the customer [91], or transferred to another individual [92] using the component [3, 127, 147] of the system. According to some embodiments, the method may comprise another individual [92] receiving the redemption option from the customer [91] using a component [3, 127, 147] of the system. According to some embodiments, the step of providing the redemption option to the customer [91] may comprise delivering the redemption option to the customer [91] in a physical form, wherein the redemption option may be immediately utilized by the customer [91] in the physical form, saved for later use by the customer [91], or transferred to another individual [92] in person or via a postal service. According to some embodiments, the step of providing the redemption option to the customer [91] may comprise delivering the redemption option to the customer [91] in a physical form, via the system kiosk [3], wherein the redemption option may be immediately utilized by the customer [91] in the physical form, saved for later use by the customer [91], or transferred to another individual [92] in person or by postal service.

According to some embodiments, the step of delivering the redemption option to the customer [91] in a physical form may comprise the system kiosk [3] delivering to the customer [91] at least one of the group consisting of: cash [11], a ticket [75], a pass [67], a coupon [16], a redemption code, a gift card [15], a voucher, a lottery ticket [82], a pawn ticket, a loan ticket, an article indicating a purchased stock or tradable fund [81], a credit card [12], a pre-paid minutes [76] card, a check [14], a card [19] comprising customer loyalty points [78], a card [19] comprising miles points, a card [19] comprising frequent diner points, a card [19] comprising cryptographic currency [18] information, a card [19] comprising cryptographic digital wallet information, a receipt [20] indicating a credit to the customer's [91] or to another individuals [92] credit card account [12], a receipt [20] indicating a credit to the customer's [91] or to another user's [92] debit account [13], a card [19] or receipt [20] indicating the customer's [91] system account credit [17] balance, a card [19] or receipt [20] indicating another individual's [92] system account credit [17] balance, a receipt [20], a card [19] comprising system-based credit [17], and postage [25]. According to some embodiments, the step of delivering the redemption option to the customer [91] in a physical form may comprise the system kiosk [3] producing a card [19]. According to some embodiments, the method may comprise the system kiosk [3] loading the card [19] with redemption data [64] and/or purchase data [9] associated with the redemption option using at least one of the group consisting of: digital write means [119] and printing means [104]. According to some embodiments, the method may comprise the system kiosk [3] loading the card [19] with redemption data [64] and/or purchase data [9] associated with the redemption option using at least one of the group consisting of: digital write means [119] and printing means [104]. According to some embodiments, the card [19] may comprise one or more of the group consisting of: a chip [86], an RFID device [88], alphanumeric text or characters [89], a barcode [79], a magnetic stripe [87], a solid state device [85], and image information [77]. According to some embodiments, the card [19] may comprise one or more of the group consisting of: an integrated circuit, a microprocessor, a security authentication device, a single sign-on SSO device, an EMV chip, an ISO/IEC 7816-compliant device, a contact-less “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8, 16, or 32-bit public key dynamic 8 k-1 MB EEPROM device with math coprocessor, a 125 kHz proximity read-only-compatible device, a 13.56 MHz ISO 14443 0.5-8 kB read/write-compatible device, a MiFare protocol-compatible device, a proprietary protocol device, an ultrahigh frequency gen 1 or ten 2 device, a semiconductor, a proximity locator chip, a ScenSor DW1000 chip by DecaWave, an IEEE 802.15.4a-compatible wireless communication device, an NFC-compatible chip, an antenna, an electromagnetic field-detectable device, a tag, a transponder, a frequency modulating/de-modulating-compatible device, a passive reader active tag device, an active reader tag device, a battery-assisted tag (BAT) device, an electronic product code (EPC) containing device, a mobile computing communication device, a virtual badge device, a wireless tracking device, a UHF inlay, a smart label, an ultra strip III label, a theft prevention security tag, an electronic article surveillance (EAS) system-compatible tag, a 1D bar code, a 2D bar code, a data matrix code, a QR code, a product code, a UPC code, an ISO/IEC 15416-compliant marking, an ISO/IEC 15426-2-compliant marking, a SO/IEC 15415-compliant marking, a ISO/IEC TR 29158-compliant marking, text, characters, numbers, letters, printed indicia, embossed indicia, cryptotext, an alphanumeric code, a high-coercivity (HiCo) magnetic device, a low-coercivity (LoCo) device, a message [41], a design [42], a stock image [38], a user name [47], an image, printed matter, a photo, a logo, indicia, a brand, trade dress, a trademark, a graphic, user data [8], a color, a puzzle, a visual game, and word art. According to some embodiments, the component [3, 127, 147] of the system to which the customer [91, 92] may provide inputs [4] is one of the system website [127] or the system application [147], and wherein the one of the system website [127] or the system application [147] is accessed by the customer [91, 92] user using a computer [95] or mobile device [96]. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD).

Also disclosed, is a system for improving a customer's [91] shopping experiences between a plurality of non-affiliated vendors or entities [65], the customer [91] having funds or credits associated with a first one of the plurality of non-affiliated vendors or entities [65] and also having funds or credits associated with a second one of the plurality of non-affiliated vendors or entities [65], the funds or credits associated with the first one of the plurality of non-affiliated vendors or entities [65] not necessarily being honorable at the second one of the plurality of nonaffiliated vendors or entities [65]. According to some embodiments, the system may comprise: a system card [19] associated with the information pertaining to the plurality of funds or credits for the first and second ones of the plurality of non-affiliated vendors or entities [65]; wherein the system card [19] may be presented to the first one of the plurality of nonaffiliated vendors or entities [65] to benefit from the funds or credits associated with the first one of the plurality of non-affiliated vendors or entities [65]; and, wherein the system card [19] may equally be presented to the second one of the plurality of non-affiliated vendors or entities [65] to benefit from the funds or credits associated with the second one of the plurality of non-affiliated vendors or entities [65]. According to some embodiments, the system may comprise a system database [128] which may comprise information pertaining to the plurality of funds or credits for the first and second ones of the plurality of non-affiliated vendors or entities [65]. According to some embodiments, the system card [19] may be linked to the system database [128]. According to some embodiments, the system may comprise payment receiving means [100] provided to both of the first and second one of the plurality of non-affiliated vendors or entities [65], the payment receiving means [100] being configured to accept the system card [19]. According to some embodiments, the payment receiving means [100] may be configured to accept system-based credits. According to some embodiments, the payment receiving means [100] may be configured to convert funds or credits which are not acceptable to system-based credits to complete a transaction. According to some embodiments, when the system card [19] is presented to the first or second one of the plurality of non-affiliated vendors or entities [65], the payment means [100] provided to the respective first or second one of the plurality of non-affiliated vendors or entities [65] may communicate with the system database [128] via the internet or other network [118] to access information regarding the funds or credits associated with the respective first or second one of the plurality of non-affiliated vendors or entities [65] sufficient to complete a transaction. According to some embodiments, the system may comprise a system financial institution [163] configured to communicate with the payment means [100], wherein when the system card [19] is presented to the first or second one of the plurality of non-affiliated vendors or entities [65], the system financial institution [163] may provide a payment to the respective first or second one of the plurality of non-affiliated vendors or entities [65] to complete a transaction. According to some embodiments, the system may comprise a system application [147] configured to accesses the system database [128] and communicate with the system financial institution [163] and payment means [100], wherein when the system card [19] is presented to the first or second one of the plurality of non-affiliated vendors or entities [65], the system application [147] accesses the system database [128] to determine if there are sufficient funds or credits associated with the respective first or second one of the plurality of nonaffiliated vendors or entities [65] to complete a transaction. According to some embodiments, the system financial institution [163] may only provide the payment to the respective first or second one of the plurality of non-affiliated vendors or entities [65] if there are sufficient funds or credits associated with the respective first or second one of the plurality of non-affiliated vendors or entities [65] to complete a transaction. According to some embodiments, the system may comprise a system application [147] which may be utilized on the customer's [91] mobile device [96] or computer [95], the system application [147] being operatively integrated with the system card [19] or the system database [128]. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the funds or credits associated with the first one of the plurality of non-affiliated vendors or entities [65] which is not necessarily honorable at the second one of the plurality of non-affiliated vendors or entities [65] may comprise one of the group consisting of: a ticket [75], a pass [67], a coupon [16], a redemption code, a gift card [15], a voucher, a lottery ticket [82], a pawn ticket, a loan ticket, stock or tradable fund [81] information, pre-paid minutes [76], customer loyalty points [78], customer loyalty program card, miles points, frequent diner points, cryptographic currency [18] information, a cryptographic digital wallet, and system-based credits.

Further disclosed, is a system for improving a customer's [91] shopping experiences between a plurality of non-affiliated vendors or entities [65], the customer [91] having funds or credits associated with a first one of the plurality of non-affiliated vendors or entities [65] and also having funds or credits associated with a second one of the plurality of non-affiliated vendors or entities [65], the funds or credits associated with the first one of the plurality of non-affiliated vendors or entities [65] not necessarily being honorable at the second one of the plurality of nonaffiliated vendors or entities [65]. According to some embodiments, the system may comprise: a kiosk [3] equipped with a user interface [106], the kiosk [3] being provided with means for consolidating the funds or credits associated with the first one of the plurality of non-affiliated vendors or entities [65] and the funds or credits associated with a second one of the plurality of non-affiliated vendors or entities [65] to a single system account. According to some embodiments, the means for consolidating may comprise reader means [110]. According to some embodiments, the reader means [110] may comprise a device selected from one or more of the group consisting of: a magnetic stripe reader, a radio frequency/RFID reader, a smart chip reader, an integrated circuit reader, a security authentication device reader, a single sign-on SSO device reader, an EMV device reader, a contactless “smart” system device reader, an inductor-comprising device reader, an ISO 7816-compliant reader, a MagTek reader, an ISO 14443-compliant reader, a MiFare protocol reader, a wireless smart phone swipe reader, a mobile tap and go device system, an RFID terminal, and an NFC-compatible reader. According to some embodiments, the means for consolidating may comprise data input means [117] configured to allow the customer [91] to manually enter funds or credits associated with one or more non-affiliated vendors or entity [65]. According to some embodiments, the system may comprise a system database [128] configured to hold information pertaining to the funds or credits associated with the first one of the plurality of non-affiliated vendors or entities [65] and the funds or credits associated with the second one of the plurality of non-affiliated vendors or entities [65]. According to some embodiments, the kiosk [3] may communicate with the system database [128], such that the kiosk [3] may store information pertaining to the funds or credits associated with the first one of the plurality of non-affiliated vendors or entities [65] and the funds or credits associated with the second one of the plurality of non-affiliated vendors or entities [65] on the system database [128], and such that the kiosk [3] may access information pertaining to the funds or credits associated with the first one of the plurality of non-affiliated vendors or entities [65] and the funds or credits associated with the second one of the plurality of non-affiliated vendors or entities [65] stored on the system database [128]. According to some embodiments, the system database [128] may be stored on a system server [129]. According to some embodiments the kiosk [3] may comprise storage means [123] for containing one or more card blanks. According to some embodiments, the system may comprise means [98] for producing a card [19] for the customer [91], wherein the card [19] produced for the customer [91] may be selected from the one or more card blanks which may be configured to be contained in the storage means [123]. According to some embodiments, the system may comprise digital write means [119], wherein the card [19] produced for the customer [91] may be configured to be loaded with information pertaining to funds or credits associated with the first one of the plurality of nonaffiliated vendors or entities [65] and the funds or credits associated with the second one of the plurality of non-affiliated vendors or entities [65] by the digital write means [119] prior to or after the customer [91] receives the card [19]. According to some embodiments, the card [19] produced for the customer [91] may be customized with one or more unique features according to one or more customer inputs [4] to the kiosk [3]. According to some embodiments, the one or more unique features may comprise image information [77] selected from one or more of the group consisting of: a message [41], a design [42], a stock image [38], a user name [47], a 1D barcode, a 2D barcode, a data matrix code, a QR code, an image, a graphic, printed matter, text, an alphanumeric code, a photo, a logo, indicia, a brand, trade dress, a trademark, user data, a color, a puzzle, a visual game, and word art. According to some embodiments, the kiosk [3] may comprise printing means [104]. According to some embodiments, the printing means [104] may be configured to print image data [6] onto one or more card blanks provided to the kiosk [3], wherein the one or more card blanks are configured to be printed on using the printing means [104]. According to some embodiments, the printing means [104] may be configured to print and deliver to the customer [91], an article selected from one or more of the group consisting of: a ticket [75], a pass [67], a coupon [16], a redemption code, a gift card [15], a voucher, a lottery ticket [82], a pawn or loan ticket, a receipt [20], a greeting card [161], a credit card [12], a debit card [13], a pre-paid minutes card [76], a card [19] comprising system-based credit [17], a check [14], and postage [25]. According to some embodiments, the kiosk [3] may be configured to be conveniently placed in a venue or location [2] which may include outdoor venues or locations. According to some embodiments, the kiosk [3] may comprise payment receiving means [100] which may incorporate an item selected from one or more of the group consisting of: software, hardware, physical apparatus for accepting payments, a bill receiving device, a bill identification system, a coin receiving device, a coin identification system, an electronic funds transfer acceptance system, a currency acceptance mechanism, a credit card acceptance system, a coupon code validation system, a gift card validation system, an EFT-POS terminal, a magnetic stripe reader, an EMV/VSDC/Mchip/AEIPS/Jsmart/D-PAS acceptance terminal, a secure online payment submission webpage, a secure checkout page, a digital wallet acceptance terminal, a digital currency exchange client, a contactless payment system, payment due calculating software, electronic payment software, electronic payment system, credit adjusting software, account information updating software, a payment application, a wireless smart phone swipe crediting system, a mobile device tap and go system, a tap and go sticker system, an NFC-compatible payment system, a digital mobile device payment application, remote deposit (capture) software, Check 21 Act-compliant online deposit software, Check 21 Act-compliant direct deposit software, and mobile deposit software. According to some embodiments, the system may comprise at least one other kiosk [3], wherein the kiosk [3] and at least one other kiosk [3] may be configured to communicate with each other via the internet or other network [118]. According to some embodiments, the kiosk [3] may comprise means selected from one or more of the group consisting of: display means [109], image scanning means [102], image capture means [116], payment acceptance means [100], hardware link means [114], audio input means [103], security means [99], housing [124], power supply means [113], printing means [104], database access means [112], data input means [117], advertising means [107], reader means [110], receipt means [141], payment dispensing means [108], card production means [98], card dispensing means [111], greeting card production means [105], a system client [162], card storage means [123], data disk reader means [115], digital write means [119], and postage means [120]. According to some embodiments, the kiosk [3] may be configured to convert non-cryptographic funds or credits to cryptographic [88] funds or credits. According to some embodiments, the kiosk [3] may be configured to convert cryptographic [88] funds or credits to non-cryptographic funds or credits. According to some embodiments, each of the plurality of non-affiliated vendors or entities [65] may comprise one or more of the following: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, or entity offering private lessons.

A system for conducting a transaction of funds or credits is also disclosed. According to some embodiments, the system may comprise: a system application [147] provided with means [100] for receiving funds or credits from a user [91]; a mobile device [96] supporting the system application [147]; wherein the system application [147] may be configured to accept one or more inputs [4] from the user [91]; wherein the system application [147] may be configured to accept a user [91] selection regarding at least one redemption option, the at least one redemption option having a native unit value; wherein the system application [147] may be configured to accept a user [91] selection regarding at least one form of payment data [10] to be used in exchange for the at least one redemption option; wherein the system application [147] may be configured to determine a value of the payment data [10] in its native unit value to define an input credit value; wherein the system application [147] may be configured to convert the input credit value to a first system-based credit value; wherein the system application [147] may be configured to define an output credit value from the native unit value of the at least one redemption option; wherein the system application [147] may be configured to convert the output credit value to a second system-based credit value; wherein the system application [147] may be configured to compare the first system-based credit value with the second system-based credit value to determine a difference in system-based credit values; and, wherein the system application [147] may be configured to provide the at least one redemption option to the user [91, 92] if the difference in system-based credit values is positive. According to some embodiments, the means [100] for receiving funds or credits may comprise one or more of the group consisting of: remote deposit (capture) software, Check 21 Act-compliant online deposit software, Check 21 Act-compliant direct deposit software, and mobile deposit software. According to some embodiments, the redemption option may be associated with purchase data [9] or redemption data [64]. According to some embodiments, the system may comprise validating or authenticating the value of the payment data [10] using security means [99]. According to some embodiments, the system may comprise validating or authenticating the value of the at least one redemption option using security means [99]. According to some embodiments, if the difference in system-based credit values is negative, the at least one redemption option may not be provided to the user [91] or otherwise redeemed by the user [91]. According to some embodiments, the system application [127] may not present or otherwise show certain redemption options to the user [91] if the difference in system-based credit values is negative. According to some embodiments, the payment data [10] may comprise a form selected from one or more of the group consisting of: a credit-based payment [12], a debit-based payment [13], a check-based payment [14], a points redemption-based payment [78], a gift card redemption-based payment [15], a voucher-based payment, a coupon-based payment [16], a redemption code-based payment, a system account credit-based payment [17], a cryptographic currency-based payment [18], a traded fund-based payment [81], a ticket-based payment [75], a pass-based payment [67], a coupon-based payment [16], a lottery-based payment [82], a pawn or loan ticket-based payment, a receipt-based payment [20], a pre-paid minutes-based payment [76], a check-based payment [14], and postage-based payment [25]. According to some embodiments, the at least one redemption option may be selected from one or more of the group consisting of: a credit-based redemption [12], a credit to the user's [91] credit card account, a debit-based redemption [13], a credit to the user's [91] debit card account, a check-based redemption [14], a points-based redemption [78], a gift card redemption [15], a voucher redemption, a coupon-based redemption [16], code-based redemption, a system account credit-based redemption [17], a cryptographic currency-based redemption [18], a traded fund-based redemption [81], a ticket-based redemption [75], a pass-based redemption [67], a coupon-based redemption [16], a lottery-based redemption [82], a pawn or loan ticket-based redemption, a receipt-based redemption [20], a greeting card-based redemption [161], a pre-paid minutes-based redemption [76], a check-based redemption [14], and a postage-based redemption [25]. According to some embodiments, the system may comprise associating information pertaining to the redemption option with a system profile [130] of the user [91]. According to some embodiments, the system application [147] may be affiliated with a system website [127]. According to some embodiments, the at least one redemption option provided to the user [91] may comprise updating [142] a system profile [130] of the user [91]. According to some embodiments, the at least one redemption option provided to the user [91] may be in an electronic form, wherein the at least one redemption option may be immediately utilized by the user [91] in the electronic form, saved for later use by the user [91], or transferred to another individual [92] using the system application [127]. According to some embodiments, the system may comprise a second mobile device [96] supporting the system application [147] or otherwise having means [101] for connecting to the internet or other network [118], wherein the user [91] receiving the at least one redemption option may transfer the at least one redemption option to the second mobile device [96] via the system application [147]. According to some embodiments, the system may comprise a system website [127] integrated with the system application [147], wherein the system may comprise a second mobile device [96] configured to access the system website [127], wherein the user [91] receiving the at least one redemption option may transfer the at least one redemption option to the second mobile device [96] via the system application [147] and system website [127], when the second mobile device [96] accesses the system website [127]. According to some embodiments, the system may comprise a computer [95] supporting the system application [147] or otherwise having means [101] for connecting to the internet or other network [118], wherein the user [91] receiving the at least one redemption option may transfer the at least one redemption option to the computer [95] via the system application [147]. According to some embodiments, the system may comprise a system website [127] integrated with the system application [147], wherein the system may comprise a computer [95] configured to access the system website [127], wherein the user [91] receiving the at least one redemption option may transfer the at least one redemption option to the computer [95] via the system application [147] and system website [127], when the computer [95] accesses the system website [127]. According to some embodiments, the system may comprise a kiosk [3] supporting the system application [147] or otherwise having means [101] for connecting to the internet or other network [118], wherein the user [91] receiving the at least one redemption option may transfer the at least one redemption option to the kiosk [3] via the system application [147]. According to some embodiments, the system may comprise a system website [127] integrated with the system application [147], wherein the system may comprise a kiosk [3] configured to access the system website [127], wherein the user [91] receiving the at least one redemption option may transfer the at least one redemption option to the kiosk [3] via the system application [147] and system website [127]. According to some embodiments, the another individual [92] may receive the at least one redemption option from the kiosk [3] at a time convenient for the another individual [92], absent the presence of the user [91]. According to some embodiments, the system may comprise a kiosk [3] and the at least one redemption option provided to the user [91] may be obtained from the kiosk [3] in a physical form at a time convenient to the user [91]. According to some embodiments, the at least one redemption option obtained from the kiosk [3] by the user [91] may be immediately utilized by the user [91] in the physical form, saved for later use by the user [91], or transferred to another individual [92] in person or via a postal service. According to some embodiments, the at least one redemption option may be selected from one or more of the group consisting of: cash [11], a ticket [75], a pass [67], a coupon [16], a redemption code, a gift card [15], a voucher, a lottery ticket [82], a pawn ticket, a loan ticket, an article indicating a purchased stock or tradable fund [81], a credit card [12], a pre-paid minutes [76] card, a check [14], a card [19] comprising user loyalty points [78], a card [19] comprising miles points, a card [19] comprising frequent diner points, a card [19] comprising cryptographic currency [18] information, a card [19] comprising cryptographic digital wallet information, a receipt [20] indicating a credit to the user's [91] or to another individuals [92] credit card account [12], a receipt [20] indicating a credit to the user's [91] or to another user's [92] debit account [13], a card [19] or receipt [20] indicating the user's [91] system account credit [17] balance, a card [19] or receipt [20] indicating another individual's [92] system account credit [17] balance, a receipt [20], system-based credit [17], and postage [25]. According to some embodiments, the at least one redemption option may comprise a card [19]. According to some embodiments, the system kiosk [3] may be configured to load the card [19] with redemption data [64] and/or purchase data [9] associated with the at least one redemption option, using at least one of the group consisting of: digital write means [119] and printing means [104]. According to some embodiments, the card [19] may comprise one or more of the group consisting of: a chip [86], an RFID device [88], alphanumeric text or characters [89], a barcode [79], a magnetic stripe [87], a solid state device [85], and image information [77]. According to some embodiments, the card [19] may comprise one or more of the group consisting of: an integrated circuit, a microprocessor, a security authentication device, a single sign-on SSO device, an EMV chip, an ISO/IEC 7816-compliant device, a contact-less “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8, 16, or 32-bit public key dynamic 8 k-1 MB EEPROM device with math coprocessor, a 125 kHz proximity read-only-compatible device, a 13.56 MHz ISO 14443 0.5-8 kB read/write-compatible device, a MiFare protocol-compatible device, a proprietary protocol device, an ultrahigh frequency gen 1 or ten 2 device, a semiconductor, a proximity locator chip, a ScenSor DW1000 chip by DecaWave, an IEEE 802.15.4a-compatible wireless communication device, an NFC-compatible chip, an antenna, an electromagnetic field-detectable device, a tag, a transponder, a frequency modulating/de-modulating-compatible device, a passive reader active tag device, an active reader tag device, a battery-assisted tag (BAT) device, an electronic product code (EPC) containing device, a mobile computing communication device, a virtual badge device, a wireless tracking device, a UHF inlay, a smart label, an ultra strip Mabel, a theft prevention security tag, an electronic article surveillance (EAS) system-compatible tag, a 1D bar code, a 2D bar code, a data matrix code, a QR code, a product code, a UPC code, an ISO/IEC 15416-compliant marking, an ISO/IEC 15426-2-compliant marking, a SO/IEC 15415-compliant marking, a ISO/IEC TR 29158-compliant marking, text, characters, numbers, letters, printed indicia, embossed indicia, cryptotext, an alphanumeric code, a high-coercivity (HiCo) magnetic device, a low-coercivity (LoCo) device, a message [41], a design [42], a stock image [38], a user name [47], an image, printed matter, a photo, a logo, indicia, a brand, trade dress, a trademark, a graphic, user data [8], a color, a puzzle, a visual game, and word art. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the at least one redemption option may be transferred from the user [91] to another individual [92]. According to some embodiments, the at least one redemption option may be selected from one or more of the group consisting of: cash [11], a ticket [75], a pass [67], a coupon [16], a redemption code, a gift card [15], a voucher, a lottery ticket [82], a pawn ticket, a loan ticket, an article indicating a purchased stock or tradable fund [81], a credit card [12], a pre-paid minutes [76] card, a check [14], a card [19] comprising user loyalty points [78], a card [19] comprising miles points, a card [19] comprising frequent diner points, a card [19] comprising cryptographic currency [18] information, a card [19] comprising cryptographic digital wallet information, a receipt [20] indicating a credit to the user's [91] or to another individual's [92] credit card account [12], a receipt [20] indicating a credit to the user's [91] or to another user's [92] debit account [13], a card [19] or receipt [20] indicating the user's [91] system account credit [17] balance, a card [19] or receipt [20] indicating another individual's [92] system account credit [17] balance, a card [19] or receipt [20] indicating the another individual's [92] system account [17] balance, a receipt [20], system-based credit [17], and postage [25]. According to some embodiments, the “another” individual [92] may receive the at least one redemption option from the first user [91] via a system kiosk [3]. According to some embodiments, the at least one redemption option may be selected from one or more of the group consisting of: electronic cash or currency [11], an electronic ticket [75], an electronic pass [67], an electronic coupon [16], an electronic redemption code, an electronic gift card [15], an electronic voucher, an electronic lottery ticket [82], an electronic pawn ticket, an electronic loan ticket, an electronic receipt indicating a purchased stock or tradable fund [81], an electronic credit card [12], electronic pre-paid minutes [76], an electronic check [14], user loyalty points [78], miles points, frequent diner points, cryptographic currency [18], cryptographic digital wallet information, an electronic receipt [20] indicating a credit to the user's [91] or to another individuals [92] credit card account [12], an electronic receipt [20] indicating a credit to the user's [91] or to another user's [92] debit account [13], an electronic receipt [20] indicating the user's [91] system account credit [17] balance, an electronic receipt [20] indicating a credit to the another individual's [92] system account [17] balance, an electronic receipt [20], system-based credit [17], and postage [25] credit. According to some embodiments, the another individual [92] may receive the at least one redemption option from the first user [91] via a mobile device [96] of the another individual [92]. According to some embodiments, the mobile device [96] of the another individual [92] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the another individual [92] may receive the at least one redemption option from the user [91] via a computer [95] of the another individual [92]. According to some embodiments, the another individual [92] may receive the at least one redemption option from the user [91] via a system website [127]. According to some embodiments, the another individual [92] may receive the at least one redemption option from the user [91] via a system website [127].

Further disclosed, is a system for improving a customer's [91] experiences with a vendor or entity [65]. In some embodiments, the system may comprise: a system website [127] and/or system application [147] which may comprise information pertaining to the vendor or entity [65]; a profile [130] associated with the customer [91]; and, means for automatically applying one or more funds, credits, or offers to the profile [130] of the customer [91]. According to some embodiments, the one or more funds, credits, or offers automatically applied to the profile [130] of the customer may be selected from one or more of the group consisting of: an electronic advertisement [107], electronic cash or currency [11], an electronic ticket [75], an electronic pass [67], an electronic coupon [16], an electronic redemption code, an electronic gift card [15], an electronic voucher, an electronic lottery ticket [82], an electronic pawn ticket, an electronic loan ticket, an electronic receipt indicating a purchased stock or tradable fund [81], an electronic credit card [12], an electronic debit card [13], electronic prepaid minutes [76], an electronic check [14], user loyalty points [78], miles points, frequent diner points, cryptographic currency [18], cryptographic digital wallet information, an electronic receipt [20] indicating a credit to the customer's [91] or to another individual's [92] credit card account [12], an electronic receipt [20] indicating a credit to the customer's [91] or to another individual's [92] debit account [13], an electronic receipt [20] indicating the customer's [91] system account credit [17] balance, an electronic receipt [20] indicating a credit to the another individual's [92] system account [17] balance, system-based credit [17], an electronic receipt [20], and postage [25] credit. According to some embodiments, the means for automatically applying one or more funds, credits, or offers to the profile [130] of the customer [91] may be configured to allow the vendor or entity [65] to apply the one or more funds, credits, or offers to the profile [130] of the customer [91]. According to some embodiments, the system website [127] and/or system application [147] may be configured to allow the vendor or entity [65] to apply the one or more funds, credits, or offers to the profile [130] of the customer [91] via the system website [127] and/or system application [147]. According to some embodiments, the means for automatically applying one or more funds, credits, or offers to the profile [130] of the customer [91] may comprise the system website [127] and/or system application [147] applying the one or more funds, credits, or offers to the profile [130] of the customer [91]. According to some embodiments, the system website [127] and/or system application [147] may apply the one or more funds, credits, or offers to the profile [130] of the customer [91] based on location data [143]. According to some embodiments, the location data [143] may comprise information pertaining to the location of the customer [91]. According to some embodiments, the information pertaining to the location of the customer [91] may comprise information pertaining to a permanent location of the customer [91]. According to some embodiments, the information pertaining to a permanent location of the customer [91] may comprise one or more of the group consisting of: the customer's [91] residential address, the customer's [91] work address, the customer's [91] home city, the customer's [91] home state, and the customer's [91] home country. According to some embodiments, the information pertaining to the location of the customer [91] may comprise information pertaining to a current location of the customer [91]. According to some embodiments, the information pertaining to a current location of the customer [91] may comprise geographic information regarding the location of the customer [91] in relation to the vendor or entity [65]. According to some embodiments, the geographic information regarding the location of the customer [91] in relation to the vendor or entity [65] may comprise a customer's [91] current physical location within a structure associated with the vendor or entity [65]. According to some embodiments, the information pertaining to the vendor or entity [65] may comprise information regarding a good or service [151] proximate to the customer's [91] current physical location within a structure associated with the vendor or entity [65]. According to some embodiments, the system may comprise an indoor positioning system [159]. According to some embodiments, the indoor positioning system [159] may be integrated with the system website [127] and/or system application [147]. According to some embodiments, the indoor positioning system [159] may comprise one or more of the group consisting of: an indoor positioning (IPS) system, a ViaLite Metro GPS-based positioning system, a turnkey fibre optic (or “optical fibre”) remoting system, an iBeacon (by Apple) system, an iBeacon-compatible system, a Navizon positioning system, a Navizon-compatible positioning system, a Meridian indoor GPS positioning system, a WiFarer indoor GPS positioning system, a WiGLE wireless geographic logging engine-based system, a geographic location engine, a Q-Track positioning system, a NFER® positioning system, a DecaWave positioning system, a Wi-Fi signal strength-based positioning system, a cellular phone signal strength-based positioning system, a Bluetooth signal-based positioning system, a WiFiSLAM positioning system, an Indoor Atlas positioning system, a Low Energy (BLE) profile positioning system for micro-location, a marker-based positioning system (e.g., Pathfindr), a ZigBee-based intelligent indoor positioning system, a visual guidance navigational technology-based positioning system, a vision guided navigational technology-based positioning system (e.g., SEEGrid), a low power OEM UWB ranging platform supporting two-way time-of-flight (TW-TOF) ranging and communications (e.g., Time Domain's PulsON® 410 (P410) module), a peer-to-peer ranging technology-based positioning system, a theft prevention-based tag system having multiple readers distributed throughout the structure (e.g., Sensormatic system), one or more antennas, a Sensormatic iREAD™ platform, a Sensormatic Ultra Max AM system, a magnetic/magneto-harmonic based positioning system, an acousto-magnetic/magnetostrictive-based positioning system, a radio frequency-based positioning system (e.g., 1.75-9.5 MHz), a microwave-based positioning system, an electromagnetic (EM) tag-based positioning system, an RFID-based positioning system (e.g., SkyRFID), an RFID/NFC-emulator—based positioning system, a video tracking-based positioning system, a blob tracking-based positioning system, a kernel/mean shift-based tracking system, a contour-based tracking system, a visual feature matching-based positioning system, a registration-based tracking system, a user voice-based tracking system, a thermal/body temperature imaging-based positioning system, a biometric recognition-compatible positioning system, an ISO/IEC 24730 RTLS-compliant based positioning system, a non-ISO/IEC 24730 RTLS-compliant based positioning system, an optical positioning system, a radio-based positioning system, an acoustic technology-based positioning system, an Android beam-based positioning system, a TecTile/sticker-based NFC-integrated positioning system, a hybrid positioning system, a transponder-based positioning system, a local positioning system, and a real-time (RTLS) locating system. According to some embodiments, the indoor positioning system [159] may comprise software associated with the indoor positioning system [159] which is supported by the website [127] and/or system application [147]. According to some embodiments, the system website [127] and/or system application [147] may be supported on a mobile device [96] of the customer [91]. According to some embodiments, the mobile device [96] of the customer [91] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the information pertaining to a current location of the customer [91] may comprise geographic information regarding the location of the customer in relation to a venue/location [2]. According to some embodiments, the geographic information regarding the location of the customer [91] in relation to a venue/location [2] may comprise a customer's [91] current physical location within a structure associated with the venue/location [2]. According to some embodiments, the information pertaining to the vendor or entity [65] may comprise information regarding a good or service [151] proximate to the customer's [91] current physical location within a structure associated with the venue/location [2]. According to some embodiments, the system may comprise an indoor positioning system [159]. According to some embodiments, the indoor positioning system [159] may be integrated with the system website [127] and/or system application [147]. According to some embodiments, the indoor positioning system [159] may comprise one or more of the group consisting of: an indoor positioning (IPS) system, a ViaLite Metro GPS-based positioning system, a turnkey fibre optic remoting system, an iBeacon (by Apple) system, an iBeacon-compatible system, a Navizon positioning system, a Navizon-compatible positioning system, a Meridian indoor GPS positioning system, a WiFarer indoor GPS positioning system, a WiGLE wireless geographic logging engine-based system, a geographic location engine, a Q-Track positioning system, a NFER® positioning system, a DecaWave positioning system, a Wi-Fi signal strength-based positioning system, a cellular phone signal strength-based positioning system, a Bluetooth signal-based positioning system, a WiFiSLAM positioning system, an Indoor Atlas positioning system, a Low Energy (BLE) profile positioning system for micro-location, a marker-based positioning system (e.g., Pathfindr), a ZigBee-based intelligent indoor positioning system, a visual guidance navigational technology-based positioning system, a vision guided navigational technology-based positioning system (e.g., SEEGrid), a low power OEM UWB ranging platform supporting two-way time-of-flight (TW-TOF) ranging and communications (e.g., Time Domain's PulsON® 410 (P410) module), a peer-to-peer ranging technology-based positioning system, a theft prevention-based tag system having multiple readers distributed throughout the structure (e.g., Sensormatic system), one or more antennas, a Sensormatic iREAD™ platform, a Sensormatic Ultra Max AM system, a magnetic/magneto-harmonic based positioning system, an acousto-magnetic/magnetostrictive-based positioning system, a radio frequency-based positioning system (e.g., 1.75-9.5 MHz), a microwave-based positioning system, an electromagnetic (EM) tag-based positioning system, an RFID-based positioning system (e.g., SkyRFID), an RFID/NFC-emulator-based positioning system, a video tracking-based positioning system, a blob tracking-based positioning system, a kernel/mean shift-based tracking system, a contour-based tracking system, a visual feature matching-based positioning system, a registration-based tracking system, a user voice-based tracking system, a thermal/body temperature imaging-based positioning system, a biometric recognition-compatible positioning system, an ISO/IEC 24730 RTLS-compliant based positioning system, a non-ISO/IEC 24730 RTLS-compliant based positioning system, an optical positioning system, a radio-based positioning system, an acoustic technology-based positioning system, an Android beam-based positioning system, a TecTile/sticker-based NFC-integrated positioning system, a hybrid positioning system, a transponder-based positioning system, a local positioning system, and a real-time (RTLS) locating system. According to some embodiments, the indoor positioning system [159] may comprise software associated with the indoor positioning system [159] which is supported by the website [127] and/or system application [147]. According to some embodiments, the system website [127] and/or system application [147] may be supported on a mobile device [96] of the customer [91]. According to some embodiments, the mobile device [96] of the customer [91] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the information pertaining to a current location of the customer [91] may comprise geographic information regarding the location of the customer in relation to a venue/location [2] adjacent the vendor or entity [65]. According to some embodiments, the venue/location [2] may be indoors. According to some embodiments, the information pertaining to the vendor or entity [65] may comprise information regarding a good or service [151] proximate to the location of the customer [91]. According to some embodiments, the means for automatically applying one or more funds, credits, or offers to the profile [130] of the customer [91] may comprise advertising means [107] integrated with the system website [127] and/or system application [147]. According to some embodiments, the advertising means [107] may be configured for presenting an offer regarding a good or service [151] to the customer [91] that is located proximate a current geographic location of the customer [91]. According to some embodiments, the advertising means [107] may comprise third party application software [148]. According to some embodiments, the system website [127] may comprise information pertaining to a plurality of vendors or entities [65]. According to some embodiments, the plurality of vendors or entities [65] are not affiliated with each other. According to some embodiments, the information pertaining to the vendor or entity [65] may comprise location data [143]. According to some embodiments, the location data [143] may comprise information relating to a layout of a venue/location [2]. According to some embodiments, the location data [143] may comprise information relating to a layout of a structure used by the vendor or entity [65]. According to some embodiments, the location data [143] may comprise information relating to a floor plan of a structure used by the vendor or entity [65]. According to some embodiments, the location data [143] may comprise information relating to a location of a particular good or service [151]. According to some embodiments, the information relating to a location of a particular good or service [151] may include a graphical display information pertaining to a layout of a structure and directional information regarding where a particular good or service [151] may be found in relation to the layout. According to some embodiments, the system website [127] and/or system application [147] may comprise a user interface [106], and the information relating to a location of a particular good or service [151] is conveyed to the customer [91] via the user interface [106]. According to some embodiments, the information relating to a layout of a venue/location [2] used by the vendor or entity [65] may comprise one or more of the group consisting of: a store layout, a building layout, a floor plan, a mall layout, a shopping center layout, a mart layout, an outlet layout, a complex layout, a fairgrounds layout, a festival layout, a market layout, an arena layout, a stadium layout, an arena layout, a casino layout, a hotel layout, a resort layout, a complex layout, and a park layout. According to some embodiments, the system may comprise location data [143] associated with the one or more funds, credits, or offers. According to some embodiments, the means for automatically applying one or more funds, credits, or offers to the profile [130] of the customer [91] may be configured to automatically apply one or more funds, credits, or offers to the profile [130] of the customer [91] as a function of the customer's [91] location. According to some embodiments, the means for automatically applying one or more funds, credits, or offers to the profile [130] of the customer [91] may be configured to automatically apply one or more funds, credits, or offers redeemable at a first vendor or entity [65] to the profile [130] of the customer [91], when the customer [91] is proximate a structure of the first vendor or entity [65]. According to some embodiments, the means for automatically applying one or more funds, credits, or offers to the profile [130] of the customer [91] may be configured to automatically apply one or more funds, credits, or offers redeemable at a first vendor or entity [65] to the profile [130] of the customer [91], when the customer [91] is browsing goods or services [151] offered by the first vendor or entity [65]. According to some embodiments, the browsing of goods or services [151] of the first vendor or entity [65] may be performed online. According to some embodiments, the browsing of goods or services [151] of the first vendor or entity [65] may be performed on the system website [127]. According to some embodiments, the browsing goods or services [151] of the first vendor or entity [65] may be performed within a structure associated with the first vendor or entity [65]. According to some embodiments, the information pertaining to the vendor or entity [65] may comprise information regarding a good or service [151]. According to some embodiments, the information regarding a good or service [151] may comprise location data [143]. According to some embodiments, the location data [143] may pertain to a physical location of the good or service [151]. According to some embodiments, the system may comprise a card [19] associated with the profile [130] of the customer [91], which may be presented to the first vendor or entity [65] or one of a plurality of vendors or entities [65] which are not affiliated with the first vendor or entity [65].

Also disclosed, is a mobile application [147] for use on and/or to be installed onto a customer's [91] mobile device [96], for improving a customer's [91] purchasing experiences. According to some embodiments, the mobile application [147] may comprise: means for communicating with an indoor positioning system [159]; location information [143] regarding the customer's [91] current location or intended destination; and, information [121] regarding a good or service [151] which is located proximate to the customer's [91] current location or intended destination. According to some embodiments, the information [121] regarding a good or service [151] which is located proximate to the customer's [91] current location or intended destination may comprise information [121] regarding a good or service [151] which is located proximate to the customer's [91] current location, and wherein the information [121] regarding a good or service [151] which is located proximate to the customer's [91] current location is delivered to the customer [91] in real-time. According to some embodiments, the information [121] regarding a good or service [151] which is located proximate to the customer's [91] current location may comprise an advertisement displayed on the customer's [91] mobile device [96]. According to some embodiments, the information [121] regarding a good or service [151] which is located proximate to the customer's [91] current location may comprise directional information which is configured to direct the customer [91] to the good or service [151] which is located proximate to the customer's [91] current location via the customer's [91] mobile device [96]. According to some embodiments, the information [121] regarding a good or service [151] which is located proximate to the customer's [91] current location may comprise instructions which are configured to direct the customer [91] to the good or service [151] which is located proximate to the customer's [91] current location via the customer's [91] mobile device [96]. According to some embodiments, the instructions which are configured to direct the customer [91] to the good or service [151] which is located proximate to the customer's [91] current location via the customer's [91] mobile device [96] may comprise information relating to one or more of the group consisting of: a relative distance between the customer [91] and the good or service [151], a relative direction between the customer [91] and the good or service [151], a relative elevation between the customer [91] and the good or service [151], turn by turn instructions, visual instructions, and audio-based instructions. According to some embodiments, the mobile application [147] may comprise advertising means [107] configured to deliver information [121] regarding the good or service [151] which is located proximate to the customer's [91] current location or intended destination. According to some embodiments, the advertising means [107] may be configured to deliver information [121] regarding one or more additional goods or services [151]. According to some embodiments, the information [121] regarding one or more additional goods or services [151] may comprise information [121] regarding additional goods or services [151] which are also located adjacent the good or service [151]. According to some embodiments, the information [121] regarding one or more additional goods or services [151] may comprise information [121] regarding additional goods or services [151] which are similar in nature to the good or service [151]. According to some embodiments, the information [121] regarding one or more additional goods or services [151] may comprise information [121] regarding additional goods or services [151] which are also located adjacent to the good or service [151]. According to some embodiments, the mobile application [147] may comprise a customer shopping list [144] associated with a customer profile [130] and also associated with the information [121] regarding the good or service [151]. According to some embodiments, the mobile application [147] may be configured to alert the customer [91] when the customer is physically proximate to the good or service [151] associated with the shopping list [144]. According to some embodiments, the mobile application [147] may comprise advertising means [107], wherein the mobile application [147] may be configured to present or otherwise automatically deliver to the customer [91] advertisements, funds, credits, or offers relating to the good or service [151] when the customer is physically proximate to the good or service [151]. According to some embodiments, the mobile application [147] may comprise a customer shopping list [144] associated with a customer profile [130] and being associated with the information [121] regarding the good or service [151], wherein the customer shopping list [144] may comprise information regarding additional goods or services [151] which are desired to be purchased by the customer [91]. According to some embodiments, the mobile application [147] may comprise advertising means [107] which is configured to present or otherwise automatically deliver to the customer [91] advertisements, funds, credits, or offers relating to the good or service [151] or relating to the additional goods or services [151] when the customer is physically proximate to the good or service [151] and/or when the customer is physically proximate to any one of the additional goods or services [151]. According to some embodiments, the mobile application [147] may comprise advertising means [107], wherein the mobile application [147] may be configured to present or automatically deliver to the customer [91] advertisements, funds, credits, or offers relating to the good or service [151] when the customer is physically proximate to the good or service [151] associated with the shopping list [144]. According to some embodiments, the information [121] regarding a good or service [151] which is located proximate to the customer's [91] current location or intended destination may comprise information [121] regarding a good or service [151] which is located proximate to the customer's [91] intended location, and wherein the information [121] regarding a good or service [151] which is located proximate to the customer's [91] intended location is delivered to the customer [91] on a map-based display. According to some embodiments, the mobile application [147] may be configured to provide instructions directing the customer [91], in real-time, to the good or service [151] which is located proximate to the customer's [91] intended location via the customer's [91] mobile device [96]. According to some embodiments, the instructions directing the customer [91], in real-time, to the good or service [151] may comprise information relating to one or more of the group consisting of: a relative distance between the customer [91] and the good or service [151], a relative direction between the customer [91] and the good or service [151], a relative elevation between the customer [91] and the good or service [151], turn by turn instructions, visual instructions, and audio-based instructions. According to some embodiments, the mobile application [147] may comprise advertising means [107]. According to some embodiments, the customer's [91] mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the information [121] regarding a good or service [151] may be stored on a system database [128]. According to some embodiments, the information [121] regarding a good or service [151] may comprise information pertaining to a vendor or entity [65]. According to some embodiments, the indoor positioning system [159] is integrated with a security system [159] of a vendor or entity [65]. According to some embodiments, the security system [159] may comprise one or more security cameras [155] and/or a security gate [157]. According to some embodiments, the indoor positioning system [159] may be integrated with an active inventory management system [153] of a vendor or entity [65]. According to some embodiments, the indoor positioning system [159] may be integrated with a signal emitter [150] or signal reflector [152] provided to a vendor or entity [65]. According to some embodiments, the indoor positioning system [159] may be integrated with one or more product tags [152]. According to some embodiments, the means for communicating with an indoor positioning system [159] may comprise one or more components of the group consisting of: a ViaLite Metro GPS-based positioning system, a turnkey fibre optic remoting system, an iBeacon (by Apple) system, an iBeacon-compatible system, a Navizon positioning system, a Navizon-compatible positioning system, a Meridian indoor GPS positioning system, a WiFarer indoor GPS positioning system, a WiGLE wireless geographic logging engine-based system, a geographic location engine, a Q-Track positioning system, a NFER® positioning system, a DecaWave positioning system, a Wi-Fi signal strength-based positioning system, a cellular phone signal strength-based positioning system, a Bluetooth signal-based positioning system, a WiFiSLAM positioning system, an Indoor Atlas positioning system, a Low Energy (BLE) profile positioning system for micro-location, a marker-based positioning system (e.g., Pathfindr), a ZigBee-based intelligent indoor positioning system, a visual guidance navigational technology-based positioning system, a vision guided navigational technology-based positioning system (e.g., SEEGrid), a low power OEM UWB ranging platform supporting two-way time-of-flight (TW-TOF) ranging and communications (e.g., Time Domain's PulsON® 410 (P410) module), a peer-to-peer ranging technology-based positioning system, a theft prevention-based tag system having multiple readers distributed throughout the structure (e.g., Sensormatic system), one or more antennas, a Sensormatic iREAD™ platform, a Sensormatic Ultra Max AM system, a magnetic/magneto-harmonic based positioning system, an acousto-magnetic/magnetostrictive-based positioning system, a radio frequency-based positioning system (e.g., 1.75-9.5 MHz), a microwave-based positioning system, an electromagnetic (EM) tag-based positioning system, an RFID-based positioning system (e.g., SkyRFID), an RFID/NFC-emulator-based positioning system, a video tracking-based positioning system, a blob tracking-based positioning system, a kernel/mean shift-based tracking system, a contour-based tracking system, a visual feature matching-based positioning system, a registration-based tracking system, a user voice-based tracking system, a thermal/body temperature imaging-based positioning system, a biometric recognition-compatible positioning system, an ISO/IEC 24730 RTLS-compliant based positioning system, a non-ISO/IEC 24730 RTLS-compliant based positioning system, an optical positioning system, a radio-based positioning system, an acoustic technology-based positioning system, an Android beam-based positioning system, a TecTile/sticker-based NFC-integrated positioning system, a hybrid positioning system, a transponder-based positioning system, a local positioning system, and a real-time (RTLS) locating system. According to some embodiments, the mobile application [147] may comprise an integrated third party application [148]. According to some embodiments, the mobile application [147] may comprise means for instantly adding a good or service [151] to the customer's [91] favorites [140] or shopping list [144]. According to some embodiments, the mobile application [147] may comprise means for determining areas of pause or heavy shopping by the customer [91]. According to some embodiments, the means for determining areas of pause or heavy shopping by the customer [91] may comprise a component of the mobile application [147] recording data pertaining to time spent by the customer [91] at a particular location.

According to some embodiments, the particular location may comprise a venue or location [2] selected from one or more of the group consisting of: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, and an entity offering private lessons. According to some embodiments, the particular location may comprise a specific location within a structure of a vendor or entity [65] selected from one or more of the group consisting of: an aisle, a quadrant, a display, an area, a floor, and a department. According to some embodiments, the mobile application [147] may be configured to track the customer's [91] location history. According to some embodiments, the customer's location history may comprise information relating to particular locations visited while within a venue or location [2] selected from one or more of the group consisting of: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, and an entity offering private lessons. According to some embodiments, the customer's location history may comprise information relating to particular locations visited while within a structure of a vendor or entity [65] selected from one or more of the group consisting of: an aisle, a quadrant, a display, an area, a floor, and a department.

A system for providing funds or credits to a user [91] is also disclosed. According to some embodiments, the system may comprise: a self-service kiosk apparatus [3] which may comprise a CPU [97]; internet connection means for accessing a system website [101]; a user interface [106]; and, payment dispensing means [108]; wherein the self-service kiosk apparatus [3] is configured to communicate with a system application [147] such that a second user [92] may send funds or credits to the user [91] using the system application [147] and the user [91] may receive the funds or credits from the second user [92] via the self-service kiosk apparatus [3]. According to some embodiments, the system may comprise the system application [147] installed on the second user's [92] mobile device [96] or computer [95]. According to some embodiments, the mobile device [96] of the second user [92] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the self-service kiosk apparatus [3] may comprise card storage means [123], card production means [98], and card dispensing means [111]. According to some embodiments, the self-service kiosk apparatus [3] may be configured to dispense a card to the user [91] which contains information corresponding to the funds or credits. According to some embodiments, the self-service kiosk apparatus [3] may be configured to be placed in a venue or location [2] for convenient user [91] access. According to some embodiments, the self-service kiosk apparatus [3] may be configured to convert funds or credits delivered to the self-service kiosk apparatus [3] by the user [91] to funds or credits in a different form or type [72].

Yet another system for providing funds or credits to a user [91] is disclosed. According to some embodiments, the system may comprise: a self-service kiosk apparatus [3] which may comprise a CPU [97]; internet connection means for accessing a system website [101]; a user interface [106]; and payment receiving means [100]; wherein the self-service kiosk apparatus [3] is configured to communicate with a system application [147] such that a second user [92] may receive funds or credits from the user [91] using the system application [147] and the user [91] may provide the funds or credits to the second user [92] via the self-service kiosk apparatus [3]. According to some embodiments, the system may comprise the system application [147] installed on the second user's [92] mobile device [96] or computer [95]. According to some embodiments, the mobile device [96] of the second user [92] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the second user [92] may instantly utilize the funds or credits provided by the first user [91] at a participating vendor or entity [65] using the mobile device [96] without additional human intervention. According to some embodiments, the funds or credits provided by the first user [91] to the second user [92] via the self-service kiosk apparatus [3] may be selected from one or more of the group consisting of: electronic cash or currency [11], an electronic ticket [75], an electronic pass [67], an electronic coupon [16], an electronic redemption code, an electronic gift card [15], an electronic voucher, an electronic lottery ticket [82], an electronic pawn ticket, an electronic loan ticket, an electronic receipt indicating a purchased stock or tradable fund [81], an electronic credit card [12], an electronic debit card [13], electronic pre-paid minutes [76], an electronic check [14], user loyalty points [78], miles points, frequent diner points, cryptographic currency [18], cryptographic digital wallet information, an electronic receipt [20] indicating a credit to the second user's [92] credit card account [12], an electronic receipt [20] indicating a credit to the second user's [92] debit account [13], an electronic receipt [20] indicating the second user's [92] system account credit [17] balance, an electronic receipt [20] indicating a credit to the second user's [92] system account [17] balance, system-based credit [17], an electronic receipt [20], and postage [25] credit.

A gift card [19] is also disclosed. According to some embodiments, the gift card [19] may comprise: funds or credits relating to a particular brand of goods or services [151], which is configured to be redeemed at a plurality of non-affiliated vendors or entities [65]. According to some embodiments, the gift card may comprise a chip [86] or an RFID device [88]. According to some embodiments, the gift card may comprise custom indicia. According to some embodiments, the custom indicia may comprise image data [6] which is associated with the particular brand of goods or services [151]. According to some embodiments, information associated with the gift card [19] may also be associated with a system website [127], a system application [147], or a system kiosk [3]. According to some embodiments, the gift card [19] may be redeemed online or at a brick-and-mortar facility of a vendor or entity [65]. According to some embodiments, the gift card [19] may be redeemed online using a system website [127]. According to some embodiments, the system application [147] may be supported by a mobile device [96] selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD).

A card [19] is also disclosed. In some embodiments, the card [19] may comprise: funds or credits relating to a particular good or service, which may be redeemed at a plurality of non-affiliated vendors or entities [65]; and wherein the card [19] may comprise a device which is tracable by an indoor positioning system [159]. According to some embodiments, the card [19] may be configured to be produced by a kiosk [3]. According to some embodiments, the card [19] may be configured to be purchased by a first remote user [91] using a system website [127], a system application [147], or a first system kiosk [3] and may also be configured to be redeemed by a second user [92] at a second system kiosk [3]. According to some embodiments, the card [19] may comprise one or more of the group consisting of: an integrated circuit, a microprocessor, a security authentication device, a single sign-on SSO device, an EMV chip, an ISO/IEC 7816-compliant device, a contact-less “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8, 16, or 32-bit public key dynamic 8 k-1 MB EEPROM device with math coprocessor, a 125 kHz proximity read-only-compatible device, a 13.56 MHz ISO 14443 0.5-8 kB read/write-compatible device, a MiFare protocol-compatible device, a proprietary protocol device, an ultrahigh frequency gen 1 or ten 2 device, a semiconductor, a proximity locator chip, a ScenSor DW1000 chip by DecaWave, an IEEE 802.15.4a-compatible wireless communication device, an NFC-compatible chip, an antenna, an electromagnetic field-detectable device, a tag, a transponder, a frequency modulating/de-modulating-compatible device, a passive reader active tag device, an active reader tag device, a battery-assisted tag (BAT) device, an electronic product code (EPC) containing device, a mobile computing communication device, a virtual badge device, a wireless tracking device, a UHF inlay, a smart label, an ultra strip Mabel, a theft prevention security tag, an electronic article surveillance (EAS) system-compatible tag, a 1D bar code, a 2D bar code, a data matrix code, a QR code, a product code, a UPC code, an ISO/IEC 15416-compliant marking, an ISO/IEC 15426-2-compliant marking, a SO/IEC 15415-compliant marking, a ISO/IEC TR 29158-compliant marking, text, characters, numbers, letters, printed indicia, embossed indicia, cryptotext, an alphanumeric code, a high-coercivity (HiCo) magnetic device, a low-coercivity (LoCo) device, a message [41], a design [42], a stock image [38], a user name [47], an image, printed matter, a photo, a logo, indicia, a brand, trade dress, a trademark, a graphic, user data [8], a color, a puzzle, a visual game, and word art. According to some embodiments, the indoor positioning system [159] may comprise one or more of the group consisting of: a ViaLite Metro GPS-based positioning system, a turnkey fibre optic remoting system, an iBeacon (by Apple) system, an iBeacon-compatible system, a Navizon positioning system, a Navizon-compatible positioning system, a Meridian indoor GPS positioning system, a WiFarer indoor GPS positioning system, a WiGLE wireless geographic logging engine-based system, a geographic location engine, a Q-Track positioning system, a NFER® positioning system, a DecaWave positioning system, a Wi-Fi signal strength-based positioning system, a cellular phone signal strength-based positioning system, a Bluetooth signal-based positioning system, a WiFiSLAM positioning system, an Indoor Atlas positioning system, a Low Energy (BLE) profile positioning system for micro-location, a marker-based positioning system (e.g., Pathfindr), a ZigBee-based intelligent indoor positioning system, a visual guidance navigational technology-based positioning system, a vision guided navigational technology-based positioning system (e.g., SEEGrid), a low power OEM UWB ranging platform supporting two-way time-of-flight (TW-TOF) ranging and communications (e.g., Time Domain's PulsON® 410 (P410) module), a peer-to-peer ranging technology-based positioning system, a theft prevention-based tag system having multiple readers distributed throughout the structure (e.g., Sensormatic system), one or more antennas, a Sensormatic iREAD™ platform, a Sensormatic Ultra Max AM system, a magnetic/magneto-harmonic based positioning system, an acousto-magnetic/magnetostrictive-based positioning system, a radio frequency-based positioning system (e.g., 1.75-9.5 MHz), a microwave-based positioning system, an electromagnetic (EM) tag-based positioning system, an RFID-based positioning system (e.g., SkyRFID), an RFID/NFC-emulator-based positioning system, a video tracking-based positioning system, a blob tracking-based positioning system, a kernel/mean shift-based tracking system, a contour-based tracking system, a visual feature matching-based positioning system, a registration-based tracking system, a user voice-based tracking system, a thermal/body temperature imaging-based positioning system, a biometric recognition-compatible positioning system, an ISO/IEC 24730 RTLS-compliant based positioning system, a non-ISO/IEC 24730 RTLS-compliant based positioning system, an optical positioning system, a radio-based positioning system, an acoustic technology-based positioning system, an Android beam-based positioning system, a TecTile/sticker-based NFC-integrated positioning system, a hybrid positioning system, a transponder-based positioning system, a local positioning system, and a real-time (RTLS) locating system.

A method of selling an article without additional human interaction, is disclosed. According to some embodiments, the method may comprise: providing a mobile device [96], wherein the mobile device [96] may comprise means for reading information associated with the article, the mobile device [96] supporting a system application [147] which is integrated with a system website [127]; placing the article within a proximity of the mobile device [96], the proximity being at least within a read zone of the means for reading information associated with the article; capturing information associated with the article using the means for reading provided to the mobile device [96]; determining a first value of the information associated with the article using the system application [147] or system website [127]; remote depositing the information associated with the article to the system website [127]; eliminating a second value of the information associated with the article from the article; and, providing funds or credits having a third value in a different form than the article, via the system application [147]. According to some embodiments, the funds or credits having a third value in a different form may be redeemed at a vendor or entity [65] which would otherwise not accept the article as a form of payment. According to some embodiments, the method may comprise the step of converting the information associated with the article to another form of saleable information using the system application [147] or the system website [127]. According to some embodiments, the second value may be equal to the first value. According to some embodiments, the third value may be less than the first value. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the information associated with the article remote-deposited to the system website [127] may be repurchased by an individual other than an individual possessing the article. According to some embodiments, the step of eliminating a second value of the information associated with the article from the article may comprise discarding the article. According to some embodiments, the means for reading may comprise a camera, barcode scanner software, QR code scanner software, or NFC-compatible device reader software.

A method of buying an article without additional human interaction is also disclosed. According to some embodiments, the method may comprise: providing a mobile device [96], wherein the mobile device [96] may comprise means for reading information associated with the article, the mobile device [96] supporting a system application [147] which is integrated with a system website [127]; placing the article within a proximity of the mobile device [96], the proximity being at least within a read zone of the means for reading information associated with the article; capturing information associated with the article using the means for reading provided to the mobile device [96]; determining a first value of the information associated with the article using the system application [147] or system website [127]; remote depositing the information associated with the article to the system website [127]; eliminating a second value of the information associated with the article from the article; providing an option to purchase the information associated with the article provided to the system website [127] at a third value; and purchasing the information associated with the article provided to the system website [127]. According to some embodiments, after the step of eliminating a second value of the information associated with the article from the article, the article may no longer be usable, saleable, or redeemable at a vendor or entity [65]. According to some embodiments, the method may comprise the step of converting the information associated with the article to another form of saleable information using the system application [147] or the system website [127]. According to some embodiments, the step of purchasing the information associated with the article provided to the system website [127] may be performed at a system kiosk [3], through the system website [127], or via the system application [147] on another mobile device [96]. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the step of converting may comprise converting the first value of the information associated with the article to a system-based unit value. According to some embodiments, the first value may be in a native value unit which is different from the system-based unit value. According to some embodiments, the step of providing an option to purchase the information associated with the article provided to the system website [127] may comprise converting the first value of the information associated with the article to a system-based unit value. According to some embodiments, the information associated with the article remote deposited to the system website [127] may be repurchased by an individual other than an individual possessing the article. According to some embodiments, the third value may be less than the first or second value. According to some embodiments, the third value may be greater than the first or second value. According to some embodiments, the second value may be equal to the first value.

A method of selling an article without additional human interaction, is also disclosed. According to some embodiments, the method may comprise one or more of the following steps: providing a kiosk [3] which may comprise means [102] for reading information associated with the article, the kiosk [3] supporting a system application [147] which is integrated with a system website [127]; placing the article within a proximity of the kiosk [3], the proximity being at least within a read zone of the means [102] for reading information associated with the article; capturing information associated with the article using the means [102] for reading provided to the mobile device [96]; determining a first value of the information associated with the article using the system application [147] or system website [127]; remote depositing the information associated with the article to the system website [127]; eliminating a second value of the information associated with the article from the article; and/or providing funds or credits having a third value in a different form than the article via the system kiosk [3]. According to some embodiments, after the step of eliminating a second value of the information associated with the article from the article, the article may no longer be usable, saleable, or redeemable at a vendor or entity [65]. According to some embodiments, the method may comprise the step of converting the information associated with the article to another form of saleable information. According to some embodiments, the step of providing funds or credits having a third value in a different form than the article may be provided to a user's mobile device [96]. According to some embodiments, the step of providing funds or credits having a third value in a different form than the article may be provided in the form of a card [19] produced by the kiosk [3]. According to some embodiments, the step of providing funds or credits having a third value in a different form than the article may be provided in the form of system-based credits which are redeemable at the kiosk [3], other system kiosks [3], a system website [127], or a participating vendor or entity [65]. According to some embodiments, the step of providing funds or credits having a third value in a different form than the article may be provided in the form of system-based credits which are redeemable at the kiosk [3], other system kiosks [3], a system website [127], or a participating vendor or entity [65]. According to some embodiments, the funds or credits having a third value in a different form than the article provided by the kiosk [3] may be instantly redeemable. According to some embodiments, the funds or credits having a third value in a different form than the article provided by the kiosk [3] may be provided to a user's mobile device [96]. According to some embodiments, the mobile device [96] may be selected from one or more of the group consisting of: a PDA, a cell phone, a smart phone, a smart watch, a gaming device, a portable computer, an internet-based digital media player, a tablet, a smart watch, a gaming device, a laptop, a VoIP-compatible device, a head-worn computing device, a wearable computer, and a wearable computer having an optical head-mounted display (OHMD). According to some embodiments, the funds or credits having a third value in a different form than the article provided by the kiosk [3] may be provided to the user's mobile device [96] via a system application [127] provided to (e.g., installed on a hard drive of, or accessed via a network connected to) the mobile device [96].

An article associated with a fund or a credit is also disclosed. According to some embodiments, the article may comprise: a surface; a first layer [401] provided to the surface, wherein the first layer [401] may comprise a machine readable authorization code which is readable in a first wavelength of light; a second layer [402] provided over the first layer [401] which is translucent or transparent at the first wavelength of light, but is not translucent or transparent in a second wavelength of light. According to some embodiments, the article may be selected from one or more of the group consisting of: a card [19], a ticket [75, 82], a slip, a check [14], a coupon [16], a receipt [20], a paper or plastic-based article, a pass [67], a credit card [12], a redemption voucher [15], and a release paper-backed sticker. According to some embodiments, the first [401] and second [402] layers may be provided on a paper-backed sticker which may be applied to any device. According to some embodiments, the first [401] and second [402] layers may be applied directly to the article via printing means [104] within a kiosk [3]. According to some embodiments, the article may be any one of a card [19], a ticket [75, 82], a slip, a check [14], a coupon [16], a receipt [20], a paper-based article, a pass [67], a credit card [12], and a redemption voucher [15], wherein one sticker of a roll of stickers may comprise the first [401] layer and second [402] layers is applied to the article before dispensing the article from the kiosk [3]. According to some embodiments, the roll of stickers may comprise a plurality of stickers, each of the plurality of stickers having different first [401] and/or second [402] layers. According to some embodiments, the first [401] and second [402] layer, when viewed in a visible wavelength of light, may comprise information regarding a user account or profile [130] or a particular redemption option. According to some embodiments, the machine-readable authorization code of the first layer [401] may comprise a key associated with the respective the user account or profile [130] or particular redemption option. According to some embodiments, the sticker may be applied to the article before dispensing the article from the kiosk [3]. According to some embodiments, the first wavelength of light may be in the infrared spectrum of light. According to some embodiments, the second wavelength of light may be in the visible spectrum of light. According to some embodiments, a human cannot read the authorization code provided to the first layer in normal ambient lighting conditions, but a machine configured to read the card [19] may, in the presence of an infrared light source, read the authorization code. According to some embodiments, portions of the first layer [401] may not be visible through the second layer [402] in the presence of the second wavelength of light. According to some embodiments, portions of the first layer [401] may not be visible through the second layer [402] in the presence of the second wavelength of light.

A method of conducting a transaction with a card [19] is further disclosed. According to some embodiments, the method may comprise one or more of the following steps: providing a card [19] having a surface; a first layer [401] provided to the surface, wherein the first layer may comprise a machine-readable authorization code which is readable in a first wavelength of light; and a second layer [402] provided over the first layer which is translucent or transparent at the first wavelength of light, but is not translucent or transparent in a second wavelength of light; and/or presenting the card [19] to an authorization code reader configured with an infrared light source. According to some embodiments, the first wavelength of light may be in the infrared spectrum of light. According to some embodiments, the second wavelength of light may be in the visible spectrum of light. According to some embodiments, a human cannot read the authorization code provided to the first layer [401] in normal ambient lighting conditions. According to some embodiments, the method may comprise scanning the second [402] and first [401] layers with the reader at a second wavelength within the visible light spectrum to determine user account or profile [130] information associated with the card [19], or to determine fund or credit information associated with the card [19]. According to some embodiments, the fund or credit information may comprise information relating to a type [72] of redemption option such as redemption data [64]. According to some embodiments, the method may comprise emitting a first wavelength of light within the infrared light spectrum and scanning the second [402] and first [401] layers with the reader at the first wavelength of light within the infrared light spectrum to determine the authenticity of the card [19].

A method of requesting funds or credits to be sent is further disclosed. According to some embodiments, the method may comprise a second user [92] at a second location [2] sending a message [41] to a first user [91] at a first location [2] via one of a system application [147], a system website [127], or a system kiosk [3]. According to some embodiments, the method may comprise the step of the first user [91] receiving the message [41] from the second user [92] via the first user's mobile device [96] or computing device [95]. According to some embodiments, the message [41] may indicate information regarding a redemption option requested by the second user [92] and/or information regarding funds or credits associated with a redemption option requested by the second user [92] which may be necessary for the one of a system application [147], a system website [127], or a system kiosk [3] to provide the redemption option to the second user [92]. According to some embodiments, the message [41] may comprise instructions to the first user [91] regarding how to send funds or credits. According to some embodiments, the instructions to the first user [91] regarding how to send funds or credits may comprise a providing a selection option to the first user [91] regarding whether to accept or decline transfer of funds or credits. According to some embodiments, the selection option may comprise an option to reply with a message. According to some embodiments, the option to reply with a message may comprise one or more of the group consisting of: an option to provide alphanumeric message information [25] to be communicated to the second user [92] via a text data entry field; an option to provide spontaneous image information [6] to be communicated to the second user [92] via image capture means [116]; an option to provide personal stored image information [6] to be communicated to the second user [92] via file upload; an option to select stock image information [6] to be communicated to the second user [92]; an option to provide spontaneous audio information [7] to be communicated to the second user [92] via voice recording; an option to provide personal stored audio information [7] to be communicated to the second user [92] via file upload; and an option to select stock audio information [7] to be communicated to the second user [92]. According to some embodiments, the selection option may comprise an option for the first user [91] to send additional funds or credits to the second user [92]. According to some embodiments, the selection to accept transfer of funds or credits may comprise the step of selecting one or more additional redemption options via a browser [131]. According to some embodiments, the message [41] to the first user [91] may be delivered to the first user's [91] mobile device [96]. According to some embodiments, the message [41] may comprise an SMS or MMS-based message sent via the first user's [91] service provider. According to some embodiments, the message [41] may comprise a system application [147]-based message. According to some embodiments, a unique sound may accompany the message [41]. According to some embodiments, the unique sound may comprise a hallmark sound which is associated with the system, such as a system trademark sound. According to some embodiments, the unique sound may be associated with the second user [92]. According to some embodiments, the message [41] may be sent via a third party application [148]. According to some embodiments, the message [41] to the first user [91] may be delivered to the first user's [91] computing device [95]. According to some embodiments, the message [41] may be in the form of a browser [131] pop-up window. According to some embodiments, the message [41] may be in the form of an email. According to some embodiments, the message [41] may be in the form of an instant message. According to some embodiments, the instant message may be delivered via a system application [147] installed on the first user's [91] computing device [95]. According to some embodiments, the instant message may be delivered via a third-party application [148] or third-party website on the first user's [91] computing device [95].

A method of offering a redemption option is also disclosed. According to some embodiments, the method may comprise one or more of the following steps: providing a browser [131] configured to display a number of redemption options [151]; displaying the number of redemption options [151] available for purchase by a user [91]; displaying a number of opinions adjacent to one or more of the number of redemption options [151]; and/or allowing a user to select a redemption option [151] using the browser [131], for example, based on the number of opinions. According to some embodiments, the number of opinions adjacent to one or more of the number of redemption options [151] may comprise a number of favorable opinions by contacts or friends [145] of the user [91] accessing the browser [131]. According to some embodiments, a first redemption option [151] of the number of redemption options [151] available for purchase may comprise a total number of favorable opinions by contacts or friends of the user [91] accessing the browser [131], wherein the total number of favorable opinions may be equivalent to the total number of user [91] contacts or friends [145] which have a favorable opinion of the first redemption option [151]. According to some embodiments, a second redemption option [151] of the number of redemption options [151] available for purchase may comprise a total number of favorable opinions by contacts or friends of the user [91] accessing the browser [131], wherein the total number of favorable opinions may be equivalent to the total number of user [91] contacts or friends [145] which have a favorable opinion of the second redemption option [151]. According to some embodiments, the total number of favorable opinions for the first redemption option [151] may be different than the second redemption option [151]. According to some embodiments, information regarding the favorable opinions by contacts or friends [145] of the user [91] accessing the browser [131] may be received from a third-party application [148]. According to some embodiments, the third-party application [148] may comprise an online social network [93]. According to some embodiments, information regarding the favorable opinions by contacts or friends [145] of the user [91] accessing the browser [131] may be received from a system kiosk [3], a system website [127], or a system application [147]. According to some embodiments, the favorable opinions by contacts or friends [145] of the user [91] accessing the browser [131] may comprise both system-based and third-party favorable opinions. According to some embodiments, the system-based favorable opinions may be represented with a first form of indicia, and the third-party favorable opinions may be represented with a second form of indicia which is different from the first form of indicia. According to some embodiments, the first form of indicia may comprise a heart shape. According to some embodiments, the third-party favorable opinions may be represented with a thumbs-up icon. According to some embodiments, the third-party favorable opinions may be represented with an icon containing a “+” (plus) sign. According to some embodiments, the first form of indicia may comprise a first number representing a first total number of favorable opinions next to the first form of indicia. According to some embodiments, a second number representing a second total number of opinions may be placed next to the second form of indicia. According to some embodiments, a number representing a total number of favorable opinions may be provided adjacent a first redemption option [151] of the number of redemption options [151] available for purchase. According to some embodiments, the number of favorable opinions may comprise a favorable opinion of a user [91] accessing the browser [131]. According to some embodiments, the number of favorable opinions may comprise a number of avatar images of contacts or friends [145] of a user [91], for example, a number of avatar images of contacts or friends [145] of a user [91] accessing the browser [131]. According to some embodiments, a first redemption option [151] of the number of redemption options [151] available for purchase may comprise a number of avatar images of contacts or friends [145] of the user [91] adjacent thereto. According to some embodiments, each avatar image may be representative of an individual who has a favorable opinion of the first redemption option [151]. According to some embodiments, a second redemption option [151] of the number of redemption options [151] available for purchase may comprise a number of avatar images of contacts or friends [145] of the user [91] adjacent thereto, wherein each avatar image may be representative of an individual who has a favorable opinion of the second redemption option [151]. According to some embodiments, one of the first or second redemption options having the largest number of avatar images may be presented on the browser [131] in a more conspicuous fashion than the other of the first or second redemption options having a lesser number of avatar images. According to some embodiments, the avatar images of contacts or friends [145] of the user [91] accessing the browser [131] may comprise system-based and/or third-party avatar images. According to some embodiments, system-based avatar images may be provided to the system via image capture means [116] provided to a system kiosk [3], or uploaded to the system using a system website [127] or system application [147]. According to some embodiments, the system application [147] may comprise a mobile application. According to some embodiments, the third-party avatar images may be imported from a third-party application [148].

A method of offering a redemption option is also provided. According to some embodiments, the method may comprise one or more of the following steps: providing a browser [131] configured to display a number of redemption options [151] available for purchase by a user [91]; providing data input means [117] to the browser [131] which may be configured to receive user input [4] regarding a recipient location [143] or otherwise determine automatically determine a recipient location [143] via recipient locating means; and/or displaying one or more appropriate redemption options [151] according to the recipient location [143], wherein the appropriate redemption options [151] may be redeemable within a proximity of the recipient location [143]. According to some embodiments, the method may comprise the step of arranging the one or more appropriate redemption options [151] by relative distance between the recipient location [143] and a physical location of one or more vendors or entities [65] providing the one or more appropriate redemption options [151]. According to some embodiments, the one or more appropriate redemption options [151] may comprise a first appropriate redemption option [151] associated with a first vendor or entity [65] located a first relative distance from the recipient location [143]. According to some embodiments, the one or more appropriate redemption options [151] may comprise a second appropriate redemption option [151] associated with a second vendor or entity [65] located a second relative distance from the recipient location [143] which is greater than the first relative distance. According to some embodiments, the first redemption option [151] may be presented on the browser [131] in a more conspicuous fashion than the second redemption option [151]. According to some embodiments, the one or more appropriate redemption options [151] may relate to the same good or service. According to some embodiments, the one or more appropriate redemption options [151] may relate to the same brand of good or service. According to some embodiments, the one or more appropriate redemption options [151] displayed may be provided by a number of unaffiliated vendors or entities [65]. According to some embodiments, the method may comprise the step of displaying the one or more appropriate redemption options on a map-based display. According to some embodiments, the method may comprise the step of displaying directional information on the map-based display.

According to some embodiments, the method may comprise the step of providing turn-by-turn directions. According to some embodiments, the turn-by-turn directions may comprise turn-by-turn directions to the location of the one or more appropriate redemption options [151], wherein the location of the one or more appropriate redemption options [151] may be indoors. According to some embodiments, the method may comprise the step of displaying one or more favorable opinions on the map-based display. According to some embodiments, the method may comprise the step of allowing a user to select an appropriate redemption option [151] using the map-based display and the one or more favorable opinions. According to some embodiments, the one or more favorable opinions may comprise favorable opinions by contacts or friends [145] of the user [91] accessing the browser [131]. According to some embodiments, the one or more favorable opinions may comprise a total number of favorable opinions. According to some embodiments, the total number of favorable opinions may be provided next to indicia. According to some embodiments, the indicia may be alpha-numeric in nature. According to some embodiments, the alphanumeric indicia may comprise the word “like” or “likes” in a predetermined language. According to some embodiments, the indicia may comprise one or more avatar images. According to some embodiments, the indicia may comprise a thumbs-up icon. According to some embodiments, the indicia may comprise a heart-shaped icon. According to some embodiments, the indicia may comprise an icon resembling a “+” (plus sign). According to some embodiments, the total number of favorable opinions may be equivalent to the total number of user [91] contacts or friends [145] which have a favorable opinion of the first redemption option [151]. According to some embodiments, the one or more favorable opinions on the map-based display may comprise a total number of favorable opinions of a population in general. According to some embodiments, the method may comprise the step of accessing the information regarding the one or more favorable opinions from a third-party application [148]. According to some embodiments, the method may comprise the step of displaying one or more favorable opinions on the map-based display. According to some embodiments, a total number of favorable opinions may be provided next to indicia. According to some embodiments, the respective favorable opinions may be shown on the map-based display in the form of indicia. According to some embodiments, the indicia shown on the map-based display may comprise one or more avatar images. According to some embodiments, the one or more avatar images may be scrollable. According to some embodiments, the one or more avatar images may be active links. According to some embodiments, the method may comprise the step of engaging the one or more active links. According to some embodiments, the method may comprise the step of the browser [131] prompting the user [91] to send a redemption option to an individual associated with the engaged avatar image.

A map-based display capable of being provided on a user interface [106] associated with a kiosk [3], a system application [147], or system website [127], wherein the map-based display may comprise indicia thereon which is representative of a favorable opinion of at least one of the group consisting of: a vendor or entity [65] located on the map-based display, a good or service [151] provided by a vendor or entity [65] located on the map-based display, and a brand of good or service [151] provided by a vendor or entity [65] located on the map-based display. According to some embodiments, the indicia may comprise a total number of favorable opinions. According to some embodiments, the indicia may be alpha-numeric in nature. According to some embodiments, the alphanumeric indicia may comprise the word “like” or “likes” in a predetermined language. According to some embodiments, the indicia may comprise one or more avatar images. According to some embodiments, the one or more avatar images may be scrollable. According to some embodiments, the one or more avatar images may be active links. According to some embodiments, the indicia may comprise a thumbs-up icon. According to some embodiments, the indicia may comprise a heart-shaped icon. According to some embodiments, the indicia may comprise an icon resembling a “+” (plus sign). According to some embodiments, the indicia on the map-based display which is representative of a favorable opinion may comprise favorable opinions by contacts or friends [145] of a user [91] accessing the user interface [106]. According to some embodiments, the indicia on the map-based display which is representative of a favorable opinion may comprise system-based and/or third-party favorable opinions. According to some embodiments, system-based favorable opinions may be represented with a first form of indicia. According to some embodiments, third-party favorable opinions may be represented with a second form of indicia which is different from the first form of indicia. According to some embodiments, the first form of indicia may comprise a heart shape. According to some embodiments, the third-party favorable opinions may be represented with a thumbs-up icon. According to some embodiments, the third-party favorable opinions may be represented with an icon. According to some embodiments, the icon may comprise a “+” (plus sign). According to some embodiments, the first form of indicia may comprise a first number representing a first total number of opinions. According to some embodiments, the second form of indicia may comprise a second number representing a second total number of opinions. According to some embodiments, the indicia may comprise a favorable opinion of a user [91] accessing the user interface [106]. According to some embodiments, the indicia may comprise a favorable opinion of contacts or friends [145] of a user [91] accessing the user interface [106]. According to some embodiments, the indicia may comprise a number of avatar images of contacts or friends [145] of a user [91] accessing the user interface [106]. According to some embodiments, each avatar image may be representative of an individual who has a favorable opinion of the vendor or entity [65], good or service [151], or brand of good or service [151]. According to some embodiments, each avatar image may comprise an active link. According to some embodiments, the third-party avatar images may be imported from a third-party application [148]. According to some embodiments, wherein vendor or entities [65], goods or services [151], or brands of goods or services [151] having a greater number of favorable opinions may be presented on the map-based display in a more conspicuous fashion than vendor or entities [65], goods or services [151], or brands of goods or services [151] having a lesser number of favorable opinions.

A method of sending funds or credits is further disclosed. According to some embodiments, the method may comprise the step of a first user [91] at a first location [2] sending a message [41] to a second user [92] at a second location via one of a system application [147], a system website [127], and a system kiosk [3]. According to some embodiments, the method may comprise the step of a second user [92] at a second location [2] receiving the message [41] from the first user [91] via the second user's mobile device [96] or computing device [95]. According to some embodiments, the message [41] may indicate information regarding a redemption option sent by the first user [91]. According to some embodiments, the message [41] may comprise instructions to the second user [92] regarding how to redeem or use the funds or credits. According to some embodiments, the instructions to the second user [92] regarding how to send funds or credits may comprise the step of providing a selection option to the second user [92] regarding whether to accept or decline transfer of funds or credits from the first user [91]. According to some embodiments, the selection option may comprise an option to reply with a message or a “thank you” gift. According to some embodiments, the option to reply with a message may comprise one or more of the group consisting of: an option to provide alphanumeric message information [25] to be communicated to the first user [91] via a text data entry field; an option to post a message to the first user's [91] system profile [130]; an option to post a message to the first user's [91] social network profile via a third-party application [148]; an option to provide spontaneous image information [6] to be communicated to the first user [91] via image capture means [116]; an option to provide personal stored image information [6] to be communicated to the first user [91] via file upload; an option to select stock image information [6] to be communicated to the first user [91]; an option to post image information [6] to the first user's [91] system profile [130]; an option to post image information [6] to the first user's [91] social network profile via a third-party application [148]; an option to provide spontaneous audio information [7] to be communicated to the first user [91] via voice recording; an option to provide personal stored audio information [7] to be communicated to the first user [91] via file upload; an option to select stock audio information [7] to be communicated to the first user [91]; an option to post audio information [7] to the first user's [91] system profile [130]; and an option to post audio information [7] to the first user's [91] social network profile via a third-party application [148]. According to some embodiments, the option to reply with a gift, such as a “thank you gift”, may comprise selecting one or more redemption options from a browser [131]. According to some embodiments, the one or more redemption options may comprise any one or more of the group consisting of: electronic funds, a ticket [75], a pass [67], a coupon [16], a redemption code, a gift card [15], a voucher, a lottery ticket [82], a pawn ticket, a loan ticket, stock or tradable fund [81], a credit card [12], pre-paid minutes [76], a check [14], customer loyalty points [78], miles points, frequent diner points, cryptographic currency [18], a credit to the second users [92] credit card account [12], a credit to the second user's [92] debit account [13], system account credit [17], a receipt [20], and postage [25]. According to some embodiments, the method may comprise the second user providing payment data [10] to purchase the one or more redemption options selected by the second user [92]. According to some embodiments, the one or more redemption options selected by the second user [92] may be instantly available for use by the first [91] user after the first user [91] receives the one or more redemption options from the second user [92]. According to some embodiments, the instructions to the second user [92] regarding how to redeem or use the funds or credits may comprise one or more of the group consisting of: an option to redeem now, an option to redeem later, an option to redeem at a kiosk, an option to add funds or credits to a card, and an option to add funds or credits to a profile. According to some embodiments, the one or more redemption options may be instantly available for use by the second [92] user after the second user [92] receives the one or more redemption options from the first user [91]. According to some embodiments, the one or more redemption options may be instantly available for use by the second [92] user after the system processes the transaction. According to some embodiments, the transaction may be processed in under 1 hour. According to some embodiments, the transaction may be processed in under 30 minutes. According to some embodiments, the transaction may be processed in under 15 minutes. According to some embodiments, the transaction may be processed in under 10 minutes. According to some embodiments, the transaction may be processed in under 5 minutes. According to some embodiments, the transaction may be processed in under 2 minutes. According to some embodiments, the transaction may be processed in under 60 seconds. According to some embodiments, the transaction may be processed in under 45 seconds. According to some embodiments, the transaction may be processed in under 30 seconds. According to some embodiments, the transaction may be processed in under 15 seconds. According to some embodiments, the transaction may be processed in under 10 seconds. According to some embodiments, the transaction may be processed in under 5 seconds. According to some embodiments, the transaction may be processed without further human interaction between the first [91] user and the second [92] user.

A system application [147] configured for sending funds or credits from a first user [91] to a second user [92] is further disclosed. According to some embodiments, the system application [147] may comprise one or more of the group consisting of: payment receiving means [100] configured to receive payment data [10] from the first user [91]; payment dispensing means [106] configured to send payment data [10] received from the first user [91]; and a user interface [106] suitable for receiving and interpreting inputs [4] made by the first user [91]. According to some embodiments, the user interface [106] may comprise a browser [131] configured to present a number of sendable redemption options to the first user [91]. According to some embodiments, the user interface [106] may be configured with means for allowing the first user [91] to select a second user [92] as an intended recipient of funds or credits. According to some embodiments, the system application [147] may be configured to be installed on a mobile device [96] of the first user [91]. According to some embodiments, the means for allowing the first user [91] to select a second user [92] as an intended recipient of funds or credits may comprise executable code for selecting a contact from a contact list. According to some embodiments, the contact list may be imported from mobile device contacts stored on the first user's [91] mobile device [96]. According to some embodiments, the contact list may be imported from contacts [145] associated with a third party application [148] or website [93]. According to some embodiments, the system application [147] may comprise a module, add-in, plug in, or API which may be configured to link a third-party application [148] account or third-party website [93] account to the system application [147]. According to some embodiments, the means for allowing the first user [91] to select a second user [92] as an intended recipient of funds or credits may comprise means for actively interacting with an avatar image of the second user [92]. According to some embodiments, the means for actively interacting with an avatar image of the second user [92] may be configured to provide an option to send funds when the avatar image is clicked, pressed, touched, dragged, operatively engaged, tactilely engaged, or right-clicked. According to some embodiments, the means for actively interacting with an avatar image of the second user [92] may comprise an active link associated with the avatar image of the second user [92]. According to some embodiments, the system application [147] may be configured to provide an option to send funds after the avatar image of the second user [92] is clicked, pressed, touched, dragged, operatively engaged, tactilely engaged, or right-clicked. According to some embodiments, the browser [131] may be configured to show one or more redemption items available for purchase by the first user [91] which may be sent to the second user [92]. According to some embodiments, the browser [131] may be configured to only show one or more redemption items of which the second user [92] has a favorable opinion. According to some embodiments, the browser [131] may be configured to only show one or more redemption items which are redeemable within a proximity of the second user's [92] permanent location. According to some embodiments, the favorable opinion of the second user [92] may comprise one or more of the group consisting of: a favorable opinion comprising three or more stars of a five star rating, a “like” associated with a social network [93], and a system-based favorite [140]. According to some embodiments, means for allowing the first user [91] to select a second user [92] as an intended recipient of funds or credits may comprise interacting with a profile [130] page of the second user [92]. According to some embodiments, the means for allowing the first user [91] to select a second user [92] as an intended recipient of funds or credits may comprise interacting with a profile [130] page of the second user [92]. According to some embodiments, the profile [130] page of the second user [92] may be selected from one or more of the group consisting of: a system profile [130], an online profile, and a profile of a third-party social network [93]. According to some embodiments, the profile [130] page of the second user [92] may comprise a profile [130] page of a contact, relative, or friend [145] of the first user [91]. According to some embodiments, the avatar image of the second user [92] may comprise indicia suggestive of a contact, relative, or friend [145] of the first user [91]. According to some embodiments, the means for allowing the first user [91] to select a second user [92] as an intended recipient of funds or credits may comprise means for actively interacting with alpha-numeric text associated with the second user [92]. According to some embodiments, the alpha-numeric text associated with the second user [92] may comprise a phone number of the second user [92]. According to some embodiments, the alpha-numeric text associated with the second user [92] may comprise a name of the second user [92]. According to some embodiments, the alpha-numeric text associated with the second user [92] may comprise a name of the second user [92]. According to some embodiments, the payment receiving means [100] may be configured to receive payment data [10] from the first user's [91] mobile digital wallet associated with the mobile device [96] of the first user [91].

A method of receiving funds or credits is further disclosed. According to some embodiments, the method may comprise a second user [92] at a second location [2] receiving a message [41] from a first user [91] at a first location [2] via the second user's mobile device [96] or computing device [95]. According to some embodiments, the message [41] may comprise redemption information [64]. According to some embodiments, the redemption information [64] may be instantly utilized by the second user [92] at vendor or entity [65] which may honor the redemption option [64], for example, upon receipt. According to some embodiments, the method may comprise the step of the first user [91] sending the message [41] to the second user [92] via one of a system application [147], a system website [127], and a system kiosk [3]. According to some embodiments, the method may comprise the step of providing to the second user [92], an option for the second user [92] to request additional funds or credits to be sent to the second user [92] from the first user [91]. According to some embodiments, the method may comprise the step of the second user [92] trading the redemption information [64] by accessing a browser [131] provided to the second user's [92] mobile device [96] or computing device [95]. According to some embodiments, the browser [131] may be provided to a system application [147] installed on the second user's mobile device [96] or computing device [95]. According to some embodiments, the method may comprise the step of selecting one or more tradable redemption options via the browser [131]. According to some embodiments, the method may comprise the step of providing to the second user [92], an option for the second user [92] to accept transfer of the redemption information [64] from the first user [91] to the second user [92]. According to some embodiments, the method may comprise the step of providing to the second user [92], an option for the second user [92] to decline transfer of the redemption information [64] from the first user [91] to the second user [92]. According to some embodiments, the method may comprise the step of providing to the second user [92], an option for the second user [92] to respond to the first user [91] with a message [41]. According to some embodiments, the method may comprise the step of the second user [92] responding to the first user [91] with a message; for example, a message which may comprise image information [6] or audio information [7]. According to some embodiments, the message [41] to the first user [91] may be delivered to the first user's [91] mobile device [96]. According to some embodiments, the message [41] may comprise an SMS or MMS-based message sent to the first user's [91] mobile device [96] via the first user's [91] service provider. According to some embodiments, the message [41] may comprise a system application [147]-based message, wherein the message [41] may be sent via the system application [147]. According to some embodiments, a unique sound may accompany the message [41]. According to some embodiments, the unique sound may comprise a hallmark sound which is associated with the system, such as a system trademark sound. According to some embodiments, the unique sound may be associated with the second user [92]; for example, suggestive of the second user [92]. According to some embodiments, the message [41] may be sent via a third party application [148]. According to some embodiments, the message [41] may be in the form of a browser [131] pop-up; such as a pop-up window. According to some embodiments, the message [41] may be in the form of an email. According to some embodiments, the message [41] may be in the form of an instant message. According to some embodiments, the instant message may be delivered via a system application [147] installed on the second user's mobile device [96] or computing device [95]. According to some embodiments, the instant message may be delivered via a third-party application [148] or third-party website on the second user's mobile device [96] or computing device [95]. According to some embodiments, the message [41] may comprise instructions to the second user [92] regarding how to redeem or use the funds or credits. According to some embodiments, the method may comprise the step of providing an option to the second user [92] an option to reply to the first user [91] with a message or a gift, such as a “thank you” gift. According to some embodiments, the option to reply with a message may comprise one or more of the group consisting of: an option to provide alphanumeric message information [25] to be communicated to the first user [91] via a text data entry field; an option to post a message to the first user's [91] system profile [130]; an option to post a message to the first user's [91] social network profile via a third-party application [148]; an option to provide spontaneous image information [6] to be communicated to the first user [91] via image capture means [116] provided to the second user's mobile device [96] or computing device [95]; an option to provide personal stored image information [6] to be communicated to the first user [91] via file upload; an option to select stock image information [6] to be communicated to the first user [91]; an option to post image information [6] to the first user's [91] system profile [130]; an option to post image information [6] to the first user's [91] social network profile via a third-party application [148]; an option to provide spontaneous audio information [7] to be communicated to the first user [91] via voice recording made with audio input means [103] provided to the second user's mobile device [96] or computing device [95]; an option to provide personal stored audio information [7] to be communicated to the first user [91] via file upload; an option to select stock audio information [7] to be communicated to the first user [91]; an option to post audio information [7] to the first user's [91] system profile [130]; and an option to post audio information [7] to the first user's [91] social network profile via a third-party application [148]. According to some embodiments, the option to reply with a gift, such as a “thank you gift”, may comprise selecting one or more redemption options from a browser [131]. According to some embodiments, the one or more redemption options may comprise any one or more of the group consisting of: electronic funds, a ticket [75], a pass [67], a coupon [16], a redemption code, a gift card [15], a voucher, a lottery ticket [82], a pawn ticket, a loan ticket, stock or tradable fund [81], a credit card [12], pre-paid minutes [76], a check [14], customer loyalty points [78], miles points, frequent diner points, cryptographic currency [18], a credit to the second users [92] credit card account [12], a credit to the second user's [92] debit account [13], system account credit [17], a receipt [20], and postage [25]. According to some embodiments, the redemption information [64] may comprise information regarding any one or more of the group consisting of: electronic funds, a ticket [75], a pass [67], a coupon [16], a redemption code, a gift card [15], a voucher, a lottery ticket [82], a pawn ticket, a loan ticket, stock or tradable fund [81], a credit card [12], pre-paid minutes [76], a check [14], customer loyalty points [78], miles points, frequent diner points, cryptographic currency [18], a credit to the second users [92] credit card account [12], a credit to the second user's [92] debit account [13], system account credit [17], a receipt [20], and postage [25]. According to some embodiments, the method may comprise the step of the second user [92] providing payment data [10] to purchase the one or more redemption options selected by the second user [92]. According to some embodiments, the one or more redemption options selected by the second user [92] may be instantly available for use by the first [91] user after the first user [91] receives the one or more redemption options from the second user [92].

A method of transferring funds or credits is further disclosed. According to some embodiments, the method may comprise the step of providing a mobile device [96] or computing device [95] having a user interface [106] and a browser [131]. According to some embodiments, the browser [131] may be integrated with a system profile [130] of a user [91] which may be logged into the mobile device [96] or computing device [95]. According to some embodiments, the system profile [130] may comprise a number of contacts, relatives, or friends [145] associated with the system profile [130] of the user [91] which may be logged into the mobile device [96] or computing device [95]. According to some embodiments, the method may comprise displaying, e.g., via the browser [131], one or more redemption options. According to some embodiments, the method may comprise the step of providing, e.g., via the user interface [106] and browser [131], means for selecting one or more redemption options. According to some embodiments, the method may comprise the step of providing, via the user interface [106] and browser [131], means for sending one or more redemption options. According to some embodiments, the method may comprise the step of displaying via the browser [131], a number of contacts, relatives, or friends [145]. According to some embodiments, the method may comprise the step of providing, via the user interface [106] and browser [131], means for selecting one or more of the number of contacts, relatives, or friends [145] as a recipient. According to some embodiments, the method may comprise the step of providing payment receiving means [100] which may be configured to receive payment data [10] from the user [91] which may be logged into the mobile device [96] or computing device [95]. According to some embodiments, the method may comprise the step of providing payment dispensing means [108] configured to disburse a redemption option to one of the number of contacts, relatives, or friends [145]. According to some embodiments, the number of contacts, relatives, or friends [145] may be received from a third-party application [148]. According to some embodiments, the method may comprise the step of selecting one or more of the displayed number of contacts, relatives, or friends [145]. According to some embodiments, the step of selecting one or more of the displayed number of contacts, relatives, or friends [145] may be performed by a user [91] which may be logged into the mobile device [96] or computing device [95]. According to some embodiments, the method may comprise the step of providing, via the browser [131], an option for a user [91] to add one or more redemption options to a cart [133] associated with the selected one or more of the displayed number of contacts, relatives, or friends [145]; wherein the option may be taken by a user [91] which may be logged into the mobile device [96] or computing device [95]. According to some embodiments, the method may comprise the step of providing, via the browser [131], an option for a user [91] to proceed to a checkout page [132] to purchase the one or more redemption options added to the cart [133; wherein the option may be taken by a user [91] which may be logged into the mobile device [96] or computing device [95]. According to some embodiments, the method may comprise the step of providing, via the browser [131], an option for a user [91] to proceed to a checkout page [132] to purchase the one or more redemption options; wherein the option may be taken by a user [91] which may be logged into the mobile device [96] or computing device [95]. According to some embodiments, the method may comprise the step of providing to the checkout page [132], an option to select a type of payment data [10] desired to purchase the one or more redemption options. According to some embodiments, the method may comprise the step of providing, via the browser [131], an option to select a type of payment data [10] desired to purchase the one or more redemption options. According to some embodiments, the method may comprise the step of providing, via the browser [131], an option to select payment data [10] from one of the group consisting of: a digital wallet, an account on file, and redemption data [64] associated with the system profile [130] of a user [91] which may be logged into the mobile device [96] or computing device [95]. According to some embodiments, the redemption data [64] may comprise information selected from one or more of the group consisting of: a ticket [75], a pass [67], a coupon [16], a redemption code, a gift card [15], a voucher, a lottery ticket [82], a pawn or loan ticket, a receipt [20], a greeting card [161], a credit card [12], a pre-paid minutes card [76], a check [14], postage [25]; or information, funds, or credits relating to the one or more of the group consisting of: a ticket [75], a pass [67], a coupon [16], a redemption code, a gift card [15], a voucher, a lottery ticket [82], a pawn or loan ticket, a receipt [20], a greeting card [161], a credit card [12], a pre-paid minutes card [76], a check [14], and postage [25]. According to some embodiments, the payment data [10] may comprise information selected from one or more of the group consisting of: credit-based payment data [12], debit-based payment data [13], check-based payment data [14], points redemption-based payment data [78], gift card redemption-based payment data [15], voucher-based payment data, coupon-based payment data [16], redemption code-based payment data, system account credit-based payment data [17], cryptographic currency-based payment data [18], traded fund-based payment [81] data, ticket-based payment data [75], pass-based payment data [67], coupon-based payment data [16], lottery-based payment data [82], pawn or loan ticket-based payment data, receipt-based payment data [20], pre-paid minutes-based payment data [76], check-based payment data [14], and postage-based payment data [25]. According to some embodiments, the step of displaying, via the browser [131], one or more redemption options may comprise displaying only one or more redemption options which have a favorable opinion by the one or more of the number of contacts, relatives, or friends [145] selected as a recipient. According to some embodiments, the favorable opinion may comprise a system-based favorite [140]. According to some embodiments, the favorable opinion may comprise indicia representing a “like”; for example, indicia suggesting liking an item, product, good, or service. According to some embodiments, the indicia representing a “like” may be affiliated with a third-party application [148]. According to some embodiments, the step of displaying, via the browser [131], one or more redemption options may comprise displaying only one or more redemption options which have a favorable opinion by the number of contacts, relatives, or friends [145]. According to some embodiments, the number of contacts, relatives, or friends [145] may comprise one or more contacts provided to a mobile device [96]. According to some embodiments, the step of selecting one or more of the number of contacts, relatives, or friends [145] as a recipient may comprise selecting the one or more contacts provided to the mobile device [96]. According to some embodiments, the method may comprise the step of providing a system application [147] supporting the browser [131] and user interface [106]. According to some embodiments, the step of displaying, via the browser [131], one or more redemption options, may comprise not displaying one or more redemption options which have a negative opinion by the number of contacts, relatives, or friends [145].

A method of providing authorization is further disclosed. According to some embodiments, the method may comprise one or more of the steps consisting of: providing reader means [102]; providing a card [19] having information thereon; providing a mobile device [96]; presenting the card [19] to the reader means [102]; reading the information associated with the card [19] with the reader means [110]; triggering a request for first authentication data to be sent upon reading the information associated with the card [19]; sending the first authentication data to the mobile device [96]; and presenting the first authentication data sent to the mobile device [96]. According to some embodiments, the method may comprise the step of providing scanner means [102]. According to some embodiments, the first authentication data may comprise image data [6]. According to some embodiments, the step of presenting the first authentication data sent to the mobile device [96] may comprise the step of presenting a display of the mobile device [96] having the first authentication data provided thereto adjacent to the scanner means [102]. According to some embodiments, the method may comprise the step of sending the first authentication data to the scanner means [102]. According to some embodiments, the method may comprise the step of scanning the display of the mobile device [96] having the first authentication data thereon. According to some embodiments, the method may comprise the step of comparing the first authentication data sent to the scanner means [102] with the first authentication data provided to the display of the mobile device [96]. According to some embodiments, the method may comprise the step of verifying the card [19]. According to some embodiments, the method may comprise the step of allowing the card [19] to be used for a transaction; for example, after the step of verifying the card [19]. According to some embodiments, the transaction may comprise a login to a kiosk [3]; for example, the action of logging into a system application [147] or profile [130] of a user [91] of the card [19], via the kiosk [3]. According to some embodiments, the transaction may comprise a purchase. According to some embodiments, the transaction may comprise a redemption; for example, a redemption for an item, product, good, or service. According to some embodiments, the method may comprise the step of providing audio input means [103] adjacent the reader means [110]. According to some embodiments, the first authentication data may comprise audio data [7]. According to some embodiments, the step of presenting the first authentication data sent to the mobile device [96] may comprise emitting the audio data [7] from the mobile device [96] adjacent the audio input means [103]. According to some embodiments, the step of emitting the audio data [7] may be user-prompted. According to some embodiments, the step of emitting the audio data [7] may be automatic. According to some embodiments, the method may comprise the step of sending the first authentication data to the reader means [110]. According to some embodiments, the method may comprise the step of interpreting the audio data [7] emitted from the mobile device [96]. According to some embodiments, the method may comprise the step of comparing the first authentication data sent to the reader means [110] with the audio data [7] emitted from the mobile device [96]. According to some embodiments, the first authentication data may be configured to be utilized as an equivalent of a personal identification number (PIN). According to some embodiments, the first authentication data may comprise image data [6] selected from one or more of the group consisting of: a password, a passphrase, a message [41], a design [42], a 1D barcode, a 2D barcode, a data matrix code, a QR code, an image, a graphic, printed matter, text, characters, an alpha-numeric code, a photo, indicia, user data [8], a color, and a CAPTCHA code image. According to some embodiments, the first authentication data may comprise a CAPTCHA code image. According to some embodiments, the method may comprise the step of providing data input means [117] adjacent the reader means [110]. According to some embodiments, the step of presenting the first authentication data sent to the mobile device [96] may comprise entering the CAPTCHA code associated with the CAPCHA code image using the data input means [117]. According to some embodiments, the method may comprise the step of providing a data input means [117] adjacent the reader means [110] which may be configured to receive CAPTCHA codes. According to some embodiments, the method may comprise the step of sending information pertaining to the first authentication data to the reader means [110]. According to some embodiments, the information pertaining to the first authentication data may comprise a CAPTCHA code associated with the CAPCHA code image sent to the mobile device [96]. According to some embodiments, the method may comprise the step of comparing the CAPTCHA code sent to the reader means [110] with the CAPTCHA code associated with the CAPCHA code image entered using the data input means [117].

A method of providing authorization is further disclosed. According to some embodiments, the method may comprise one or more of the steps consisting of: providing scanning means [102]; providing a mobile device [96] having indicia displayed thereon; presenting the mobile device [96] proximate to the scanning means [102]; reading the indicia displayed on the mobile device [96] with the scanning means [102]; triggering a request for first authentication data to be sent upon reading the indicia displayed on the mobile device [96]; sending a first authentication data to the mobile device [96]; and presenting the first authentication data sent to the mobile device [96]. According to some embodiments, the first authentication data may comprise image data [6]. According to some embodiments, the step of presenting the first authentication data sent to the mobile device [96] may comprise presenting a display of the mobile device [96] having the first authentication data provided thereto adjacent to the scanner means [102]. According to some embodiments, the method may comprise the step of sending the first authentication data to the scanner means [102]. According to some embodiments, the method may comprise the step scanning the display of the mobile device [96] having the first authentication data thereon. According to some embodiments, the method may comprise the step comparing the first authentication data sent to the scanner means [102] with the first authentication data provided to the display of the mobile device [96]. According to some embodiments, the transaction may comprise a login to a kiosk [3]; for example, the action of logging into a system application [147] or profile [130] of a user [91], via the kiosk [3]. According to some embodiments, the transaction may comprise a purchase. According to some embodiments, the transaction may comprise a redemption; for example, a redemption for an item, product, good, or service. According to some embodiments, the method may comprise providing audio input means [103] adjacent the scanner means [102]. According to some embodiments, the first authentication data may comprise audio data [7]. According to some embodiments, the step of presenting the first authentication data sent to the mobile device [96] may comprise emitting the audio data [7] from the mobile device [96] adjacent the audio input means [103]. According to some embodiments, the step of emitting the audio data [7] may be user-prompted. According to some embodiments, the step of emitting the audio data [7] may be automatic. According to some embodiments, the method may comprise sending the first authentication data to the scanning means [102]. According to some embodiments, the method may comprise interpreting the audio data [7] emitted from the mobile device [96]. According to some embodiments, the method may comprise comparing the first authentication data sent to the scanning means [102] with the audio data [7] emitted from the mobile device [96]. According to some embodiments, the method may comprise verifying the indicia displayed on the mobile device [96] and allowing the indicia displayed on the mobile device [96] to be used for a transaction. According to some embodiments, the first authentication data may be configured to be utilized as an equivalent of a personal identification number (PIN). According to some embodiments, the first authentication data may comprise image data [6] selected from one or more of the group consisting of: a password, a passphrase, a message [41], a design [42], a 1D barcode, a 2D barcode, a data matrix code, a QR code, an image, a graphic, printed matter, text, characters, an alpha-numeric code, a photo, indicia, user data [8], a color, and a CAPTCHA code image. According to some embodiments, the first authentication data may comprise a CAPTCHA code image. According to some embodiments, the method may comprise providing data input means [117] adjacent the scanner means [102]. According to some embodiments, the step of presenting the first authentication data sent to the mobile device [96] may comprise the step of entering the CAPTCHA code associated with the CAPCHA code image using the data input means [117]. According to some embodiments, the method may comprise the step of providing data input means [117] adjacent the reader means [110] which may be configured to receive CAPTCHA codes. According to some embodiments, the method may comprise the step of sending information pertaining to the first authentication data to the reader means [110]. According to some embodiments, the information pertaining to the first authentication data may comprise a CAPTCHA code associated with the CAPCHA code image sent to the mobile device [96]. According to some embodiments, the method may comprise the step of comparing the CAPTCHA code sent to the reader means [110] with the CAPTCHA code associated with the CAPCHA code image entered using the data input means [117]. According to some embodiments, the transaction may comprise a login to a kiosk [3]; for example, the action of logging into a system application [147] or profile [130] of a user [91], via the kiosk [3]. According to some embodiments, the transaction may comprise a purchase. According to some embodiments, the transaction may comprise a redemption; for example, a redemption for an item, product, good, or service. According to some embodiments, the first authentication data may comprise an alphanumeric code. According to some embodiments, the method may comprise the step of providing data input means [117] adjacent the scanner means [102]. According to some embodiments, the step of presenting the first authentication data sent to the mobile device [96] may comprise entering the alpha-numeric code using the data input means [117]. According to some embodiments, the first authentication data may comprise one or more of the codes selected from the group consisting of: a 1D barcode, a 2D barcode, a data matrix code, and a QR code. According to some embodiments, the step of presenting the first authentication data sent to the mobile device [96] may comprise presenting the 1D barcode, 2D barcode, data matrix code, or QR code proximate to or adjacent to the scanning means [102].

A method of purchasing an item from a vendor or entity [65] which may not accept cryptocurrency [18] is further disclosed. According to some embodiments, an item may comprise a first cost value in a first vendor or entity [65]-accepted unit. According to some embodiments, the method may comprise the step of providing a system which may comprise a digital currency exchange client. According to some embodiments, the method may comprise the step of providing a profile [130] with the system. According to some embodiments, the profile may have payment data [10] associated therewith. According to some embodiments, the payment data [10] may comprise cryptographic currency [18] in a cryptographic currency denomination, and a public address. According to some embodiments, the method may comprise the step of providing a card [19] having information thereon, wherein the card [19] may be associated with the profile [130]. According to some embodiments, the method may comprise the step of presenting the card [19] to reader means [110] configured to read information on the card [19]. According to some embodiments, the method may comprise the step of reading the information associated with the card [19] with the reader means [110]. According to some embodiments, the method may comprise the step of converting the first cost value in a first vendor or entity [65]-accepted unit to an equivalent second cost value in a cryptographic currency denomination. According to some embodiments, the method may comprise the step of withdrawing at least the second cost value from the payment data [10] associated with the profile [130]. According to some embodiments, the method may comprise the step of crediting the card [19] with at least the first cost value in a first vendor or entity [65]-accepted unit. According to some embodiments, the card [19], once credited, may be accepted by the vendor or entity [65] which may not accept cryptocurrency [18]. According to some embodiments, the card [19] may comprise a magnetic stripe [87] or a chip [86] or an RFID device [88]. According to some embodiments, the card [19] may comprise a plastic wallet. According to some embodiments, the card [19] may comprise one or more QR codes. According to some embodiments, the card [19] may comprise a load and verify QR code. According to some embodiments, the card [19] may comprise a spend QR code. According to some embodiments, the card [19] may comprise a deterministic wallet seed. According to some embodiments, the method may comprise the step of sending a private key associated with the cryptographic currency [18] to the digital currency exchange client; for example, when information associated with the card [19] is read by the reader means [110]. According to some embodiments, the step of sending a private key may comprise accessing a user interface [106] on a mobile device [96]. According to some embodiments, at least the withdrawn second cost value from the payment data [10] associated with the profile [130] may be added to a system cyryptoaccount.

A method of providing authorization is further disclosed. According to some embodiments, the method may comprise one or more of the steps: providing scanning means [102] associated with a payment terminal [100]; providing a mobile device [96] having indicia displayed thereon;

presenting the mobile device [96] proximate to the scanning means [102]; reading the indicia displayed on the mobile device [96] with the scanning means [102]; triggering a request for first authentication data upon reading the indicia displayed on the mobile device [96]; and, presenting the first authentication data. According to some embodiments, the method may comprise the step of providing a card [19] having the first authentication data thereon. According to some embodiments, the step of presenting the first authentication data may comprise presenting the card [19]. According to some embodiments, the step of presenting the card [19] may comprise presenting the card at a point of sale to an individual for the purpose of verifying the indicia displayed on the mobile device [96]. According to some embodiments, the first authentication data may comprise image data [6]. According to some embodiments, the step of presenting the first authentication data may comprise presenting the card [19] having the first authentication data provided thereto adjacent to the scanning means [102]. According to some embodiments, the first authentication data may comprise image data [6] selected from one or more of the group consisting of: a password, a passphrase, a message [41], a design [42], a 1D barcode, a 2D barcode, a data matrix code, a QR code, an image, a graphic, printed matter, text, characters, an alpha-numeric code, a photo, indicia, user data [8], a color, and a CAPTCHA code image. According to some embodiments, the method may comprise the step of sending the first authentication data to the payment terminal [100]. According to some embodiments, the step of sending the first authentication data to the payment terminal [100] may be performed during the step of reading the indicia displayed on the mobile device [96] with the scanning means [102]. According to some embodiments, the indicia displayed on the mobile device [96] may contain information regarding a redemption option. According to some embodiments, the indicia displayed on the mobile device [96] may comprise one or more of the group consisting of: redemption data [64], purchase data [9], and payment data [10]. According to some embodiments, the indicia displayed on the mobile device [96] may comprise the first authentication data. According to some embodiments, the method may comprise the step of comparing the first authentication data sent to the payment terminal [100] with the first authentication data provided to the card [19] presented to the scanning means [102]. According to some embodiments, the method may comprise the step of sending first authentication data to the payment terminal [100] when the indicia displayed on the mobile device [96] is read by the scanning means [102]. According to some embodiments, the first authentication data may comprise audio information [7]. According to some embodiments, the method may comprise the step of providing audio input means [103] adjacent the scanning means [102] and communicating with the payment terminal [100]. According to some embodiments, the method may comprise the step of sending the first authentication data to the payment terminal [100]. According to some embodiments, the step of sending the first authentication data to the payment terminal [100] may comprise a server [122, 125, 128, 136] configured to send the first authentication data to the payment terminal [100]. According to some embodiments, the method may comprise the step of the server [122, 125, 128, 136] sending the first authentication data to the payment terminal [100]. According to some embodiments, the step of sending the first authentication data to the payment terminal [100] may be performed during the step of reading the indicia displayed on the mobile device [96] with the scanning means [102]. According to some embodiments, the indicia displayed on the mobile device [96] may comprise the first authentication data and/or information pertaining to a redemption option. According to some embodiments, the information pertaining to a redemption option may comprise one or more of the group consisting of: redemption data [64], purchase data [9], and payment data [10]. According to some embodiments, the method may comprise the step of emitting first authentication data from the mobile device [96]. According to some embodiments, the method may comprise the step of the audio input means [103] reading the emitted first authentication data. According to some embodiments, the method may comprise the step of comparing the emitted first authentication data from the mobile device [96] with the first authentication data sent to the payment terminal [100]. According to some embodiments, the first authentication data sent to the payment terminal may comprise information regarding an electronic address of the mobile device [96]. According to some embodiments, the information regarding an electronic address of the mobile device [96] may comprise the phone number of the mobile device [96]. According to some embodiments, the payment terminal [100] may communicate a unique audio sequence to the mobile device [96]. According to some embodiments, the step of emitting first authentication data from the mobile device [96] may comprise the step of emitting the unique audio sequence. According to some embodiments, the step of emitting first authentication data from the mobile device [96] may comprise the step of emitting a unique audio sequence which may then be interpreted by the payment terminal [100].

A system for providing authorization of a transaction is also disclosed. According to some embodiments, the system may comprise a terminal [3, 97, 100, 108]. According to some embodiments, the system may comprise means for reading [116, 102] an article having indicia thereon associated with the terminal [3, 97, 100, 108]. According to some embodiments, the indicia may comprise embedded information regarding a transaction and/or embedded information regarding an authentication code. According to some embodiments, the means for reading [116, 102] may be configured to read the indicia displayed on the article. According to some embodiments, the terminal [3, 97, 100, 108] may be configured to interpret the embedded information and the embedded information regarding an authentication code. According to some embodiments, the terminal [3, 97, 100, 108] be configured to receive secondary input [4] associated with the embedded information regarding an authentication code. According to some embodiments, the terminal [3, 97, 100, 108] may be configured to interpret received secondary input associated with the embedded information regarding an authentication code. According to some embodiments, the terminal [3, 95, 97, 100, 108] may be configured to prompt a user [92] providing the article having indicia thereon, to provide an input [4] regarding the authentication code. According to some embodiments, the authentication code may have been previously provided to the user [92] by an individual [91] or vendor/entity [65] that provided the user [92] with the article having indicia thereon. According to some embodiments, the terminal [3, 97, 100, 108] may comprise means configured to receive the input [4], wherein the means configured to receive the input [4] may be selected from one or more of the group consisting of: a user interface [106], audio input means [103], and data input means [117]. According to some embodiments, the authentication code may comprise a password or pass phrase. According to some embodiments, the authentication code may comprise an alpha-numeric code which may be entered using data input means [117]. According to some embodiments, the authentication code may comprise a verbal password or passphrase which may be spoken aloud by the user [92] and received by the terminal [3, 97, 100, 108] using audio input means [103]. According to some embodiments, the terminal [3, 97, 100, 108] may be configured to compare the input [4] regarding the authentication code provided by the user [92] in order to validate the article having indicia thereon; for example, to complete a transaction. According to some embodiments, the authentication code may comprise image data [6] selected from one or more of the group consisting of: a design, a 1D barcode, a 2D barcode, a data matrix code, a QR code, an image, a graphic, printed matter, text, characters, an alphanumeric code, a photo, indicia, user data [8], a color, and a CAPTCHA code image. According to some embodiments, the embedded information regarding an authentication code may comprise user data [8]. According to some embodiments, the embedded information regarding an authentication code may comprise one or more of a phone number [53], an account number [48], and/or a name [47] of an intended recipient [92] of an article having indicia thereon. According to some embodiments, the embedded information regarding an authentication code may comprise a phone number [53] of an intended recipient of an article having indicia thereon. According to some embodiments, the terminal [3, 97, 100, 108] may be configured to send authentication data to a mobile device [96] associated with the phone number [53]; for example, when the terminal [3, 97, 100, 108] interprets the embedded information regarding an authentication code. According to some embodiments, the authentication data configured to be sent by the terminal [3, 97, 100, 108] may be randomly generated. According to some embodiments, the authentication data configured to be sent by the terminal [3, 97, 100, 108] may contain image data [6]. According to some embodiments, the authentication data configured to be sent by the terminal [3, 97, 100, 108] may contain audio data [7]. According to some embodiments, the authentication data sent to the mobile device [96] may be conveyed back to the terminal [3, 97, 100, 108]. According to some embodiments, the authentication data sent to the mobile device [96] may be conveyed back to the terminal [3, 97, 100, 108] in the form of image data [6]. According to some embodiments, the authentication data sent to the mobile device [96] by the terminal [3, 97, 100, 108] may be conveyed back to the terminal [3, 97, 100, 108] in the form of image data [6]. According to some embodiments, the authentication data may be received by means provided to the terminal [3, 97, 100, 108] selected from one or more of the group consisting of: image capture means [116] and scanning means [102]. According to some embodiments, the authentication data sent to the mobile device [96] by the terminal [3, 97, 100, 108] may be conveyed back to the terminal [3, 97, 100, 108] in the form of audio data [7], and may be received by audio input means [103] provided to the terminal [3, 97, 100, 108]. According to some embodiments, the authentication data sent to the mobile device [96] by the terminal [3, 97, 100, 108] may be conveyed back to the terminal [3, 97, 100, 108] in the form of a wireless signal, and may be received by reader means [110] provided to the terminal [3, 97, 100, 108]. According to some embodiments, the wireless signal may be delivered via near field communication (NFC) protocol. According to some embodiments, the reader means [110] may be configured to read wireless signals delivered via near field communication (NFC) protocol. According to some embodiments, the embedded information regarding an authentication code may comprise an account number [48] or name [47] of an intended recipient [92] of an article having indicia thereon. According to some embodiments, the terminal [3, 97, 100, 108] may be configured to receive information associated with a card [19]. According to some embodiments, the terminal [3, 97, 100, 108] may comprise a card reader configured to receive information associated with a card [19]. According to some embodiments, the card reader may comprise image capture means [116] configured to receive information pertaining to indicia provided on the card [19], such as image data [6] or alpha-numeric information [89]. According to some embodiments, the card reader may comprise scanning means [102] which may be configured to receive information pertaining to indicia provided on the card [19], such as a type of barcode [79]. According to some embodiments, the card reader may comprise reader means [110] which may be configured to receive information pertaining to digital information associated with the card [19]. According to some embodiments, the reader means [110] may be configured to receive information pertaining to digital information associated with the card [19] via contact between the reader means [110] and the card [19], such as a magnetic stripe [87] or chip [86]. According to some embodiments, the reader means [110] may be configured to receive information pertaining to digital information associated with the card [19] without contact between the reader means [110] and the card [19]. According to some embodiments, the reader means [110] may comprise a near field communication (NFC) protocol device, and the card [19] may comprise a near field communication (NFC) protocol device [86]. According to some embodiments, the reader means [110] may comprise an RFID reader, and the card [19] may comprise an RFID tag [88]. According to some embodiments, the terminal [3, 97, 100, 108] may be configured to compare the information associated with a card [19] received by the card reader, with the account number [48] or name [47] of an intended recipient [92] of an article having indicia thereon. According to some embodiments, the information associated with a card [19] received by the card reader may comprise an account number [48] or name [47] associated with the card [19]. According to some embodiments, if the account number [48] or name [47] associated with the card [19] is the same as the account number [48] or name [47] of an intended recipient [92] of an article having indicia thereon (which may be determined from the embedded information regarding an authentication code within the indicia), then a transaction utilizing the article having indicia thereon may proceed. According to some embodiments, the transaction may comprise a redemption, the terminal [3, 97, 100, 108] may comprise a redemption terminal, and the article having indicia thereon may be selected from one or more of the group consisting of: a physical coupon [16], a digital coupon [16], a physical voucher, an electronic voucher, a redemption code, a physical gift card [15], an electronic gift card [15], an eGift certificate, a physical ticket [75], an electronic ticket [75], a physical pass [67], an electronic pass [67], a physical lottery ticket [82], an electronic lottery ticket [82], a physical pawn or loan ticket, an electronic pawn or loan ticket, a physical document containing stock or tradable fund [81] information, an electronic document containing stock or tradable fund [81] information, a physical credit card [12], an electronic credit card [12], a physical debit card [13], an electronic debit card [13], a physical pre-paid minutes [76] card, an electronic prepaid minutes [76] redemption, a physical check [14], an electronic check [14], a physical receipt [20], an electronic receipt [20], a physical cash [11] voucher, an electronic cash [11] voucher, a casino chip, a physical customer loyalty points [78] card, a digital customer loyalty points card, a physical miles reward points card, an electronic miles rewards points card, a physical frequent diner points card, an electronic frequent diner points card, a cryptographic currency [18] paper wallet, a cryptographic currency [18] coin, a cryptographic currency [18] digital wallet, a digital wallet, a mobile wallet, a physical or electronic credit, a physical postage [25] slip, an electronic postage [25] slip, electronic postage [25], a physical postage [25] credit card, an electronic postage credit card, a card [19], and a mobile device [96] display. According to some embodiments, the terminal [3, 97, 100, 108] may be located at a point of sale.

A method of shopping is further disclosed. According to some embodiments, the method may comprise a user [91] within a venue or location [2] approaching a vendor or selling entity [65] provided with a device configured to transmit a signal within a zone of proximity. According to some embodiments, a mobile device [96] associated with the user [91] may receive the signal; for example, when the user [91] enters the zone of proximity. According to some embodiments, the signal may comprise information relating to a redemption option. According to some embodiments, the method may comprise the step of displaying the information relating to a redemption option on the mobile device [96]. According to some embodiments, the information relating to a redemption option may comprise redemption data [64] or information pertaining to a good or service [151] provided by the vendor or selling entity [65]. According to some embodiments, the information relating to a redemption option may comprise information relating to a plurality of redemption options. According to some embodiments, the device configured to transmit a signal within a zone of proximity may comprise a plurality of devices configured to transmit a signal within a zone of proximity. According to some embodiments, the zones of proximity may be spaced within a structure of the vendor or selling entity [65]. According to some embodiments, the method may comprise the step of providing a first signal transmitted by a first device which may be configured to transmit a first signal within a first zone of proximity. According to some embodiments, the method may comprise the step of providing a second signal transmitted by a second device which may be configured to transmit a second signal within a second zone of proximity. According to some embodiments, the first and second signals may be different and the first zone of proximity and second zone of proximity may be spaced from one another. According to some embodiments, the method may comprise the step of the user [91] entering the first zone of proximity and receiving the first signal. According to some embodiments, the first signal may comprise information relating to a first redemption option. According to some embodiments, the information relating to a first redemption option may comprise information pertaining to a first good or service [151]. According to some embodiments, the information pertaining to a first good or service [151] may comprise information regarding a first offer, promotion, sale, coupon, discount, price, rating, opinion [140], on-your-shopping list [144] alert, notification, you-have-credit alert [64], and/or location data [143] pertaining to the first good or service [151]. According to some embodiments, the information pertaining to a first good or service [151] may comprise information regarding a first on-your-shopping list [144] alert. According to some embodiments, the first on-your-shopping list [144] alert may comprise a notification that the first good or service [151] is on the user's [91] electronic shopping list [144]. According to some embodiments, the information pertaining to a first good or service [151] may comprise information regarding a first you-have-credit [64] alert.

According to some embodiments, the first you have-credit [64] alert may comprise a notification that the user [91] has redemption data [64] which may be used as funds or credits to purchase all or a part of the first good or service. According to some embodiments, the information pertaining to a first good or service [151] may comprise information regarding first location data [143]. According to some embodiments, the first location data [143] may comprise a notification regarding where the user [91] may find the first good or service. According to some embodiments, the information pertaining to a first good or service [151] may comprise information regarding a first opinion [140]. According to some embodiments, the first opinion [140] may comprise a notification that a favorite [140] good or service [151] of the user [91] and/or a favorite [140] good or service [151] of at least one of the user's [91] contacts or friends [145] is nearby; for example, nearby in relation to a current location of the user [91]. According to some embodiments, the method may comprise the step of the user [91] entering the second zone of proximity and receiving the second signal. According to some embodiments, the method may comprise the step of the user [91] entering the second zone of proximity and receiving the second signal. According to some embodiments, the second signal may comprise information relating to a second redemption option. According to some embodiments, the information pertaining to a second good or service [151] may comprise information regarding a second offer, promotion, sale, coupon, discount, price, rating, opinion [140], on-your-shopping list [144] alert, notification, you-have credit alert [64], and/or location data [143] pertaining to the second good or service [151]. According to some embodiments, the information pertaining to a second good or service [151] may comprise information regarding a second on-your-shopping list [144] alert. According to some embodiments, the second on-your-shopping list [144] alert may comprise a notification that the second good or service [151] is on the user's [91] electronic shopping list [144]. According to some embodiments, the information pertaining to a second good or service [151] may comprise information regarding a second you-have-credit [64] alert. According to some embodiments, the second you-have-credit [64] alert may comprise a notification that the user [91] has redemption data [64] which may be used as funds or credits to purchase all or a part of the second good or service. According to some embodiments, the information pertaining to a second good or service [151] may comprise information regarding second location data [143]. According to some embodiments, the second location data [143] may comprise a notification regarding where the user [91] may find the second good or service. According to some embodiments, the information pertaining to a second good or service [151] may comprise information regarding a second opinion [140]. According to some embodiments, the second opinion [140] may comprise a notification that a favorite [140] good or service [151] of the user [91] and/or a favorite [140] good or service [151] of at least one of the user's [91] contacts or friends [145] is nearby; for example, nearby in relation to a current location of the user [91]. According to some embodiments, the method may comprise the step of presenting an option to the user [91], for example, via the user's [91] mobile device [96], to purchase the second good or service [151] for the at least one of the user's [91] contacts or friends [145]. According to some embodiments, the method may comprise the step of the user [91] accepting the option to purchase the second good or service [151] for the at least one of the user's [91] contacts or friends [145]. According to some embodiments, the method may comprise the step of deducting funds associated with a profile [130] of the user [91]; for example, after the step of the user [91] accepting the option to purchase the second good or service [151] for the at least one of the user's [91] contacts or friends [145]. According to some embodiments, the method may comprise the step of sending information regarding the second good or service [151] purchased by the first user [91]; for example, via the user's mobile device [96], to the at least one of the user's [91] contacts or friends [145]. According to some embodiments, the step of sending information regarding the second good or service [151] may comprise sending the information regarding the second good or service [151] to one of the group consisting of: a mobile device [96] associated with the at least one of the user's [91] contacts or friends [145], an email address [49] associated with the at least one of the user's [91] contacts or friends [145], and a profile [130] associated with the at least one of the user's [91] contacts or friends [145]. According to some embodiments, the step of sending information regarding the second good or service [151] may comprise sending the information regarding the second good or service [151] to a profile [130] associated with the at least one of the user's [91] contacts or friends [145]. According to some embodiments, the method may comprise posting information regarding the second good or service [151] to the profile [130] associated with the at least one of the user's [91] contacts or friends [145]. According to some embodiments, the profile [130] associated with the at least one of the user's [91] contacts or friends [145] may comprise a social network [93] profile.

A method of gifting is further disclosed. According to some embodiments, the method may comprise the step of providing a system application [147] which may be configured to be supported by (e.g., downloaded to a hard drive of, and/or used on) a mobile device [96] of a user [91]. According to some embodiments, the mobile device [96] may be configured with reader means [116] for reading indicia. According to some embodiments, the method may comprise the step of reading indicia pertaining to a good or service [151] with the reader means [116] of the mobile device [96]. According to some embodiments, the method may comprise the step of presenting an option to purchase the good or service [151] associated with the indicia for a contact or friend [145] of the user [91]. According to some embodiments, the method may comprise the step of the user [91] accepting the option to purchase the good or service [151] for the contact or friend [145]. According to some embodiments, the method may comprise the step of deducting funds or credits associated with a profile [130] of the user [91]. According to some embodiments, the method may comprise the step of sending information regarding the good or service [151] purchased by the user [91] via the user's [91] mobile device [96], to the contact or friend [145]. According to some embodiments, the step of sending information regarding the good or service [151] may comprise sending the information regarding the good or service [151] to one or more of the group consisting of: a mobile device [96] associated with the contact or friend [145], an email address [49] associated with the contact or friend [145], and a profile [130] associated with the contact or friend [145]. According to some embodiments, the step of sending information regarding the good or service [151] may comprise sending the information regarding the good or service [151] to a profile [130] associated with the contact or friend [145]. According to some embodiments, the method may comprise the step of posting information regarding the good or service [151] to the profile [130]. According to some embodiments, the profile [130] may comprise a social network [93] profile. According to some embodiments, the reader means provided to the mobile device [96] may comprise a camera or image capture means [116]. According to some embodiments, the indicia may comprise a type of barcode [79], such as a 1D barcode, 2D barcode, QR code, or data matrix code. According to some embodiments, the reader means provided to the mobile device [96] may comprise an application [147]; for example, an application [147] which may be capable of reading NDEF, RFID, FeliCa, or ISO 14443-based tags. According to some embodiments, the indicia may comprise a NDEF, RFID, FeliCa, or ISO 14443-based tag. According to some embodiments, the reader means may be configured to perform the step of reading the indicia using a near field (NFC) communication protocol.

A system application [147] is further disclosed. According to some embodiments, the system application [147] may be configured to be supported by a mobile device [96] of a user [91]. According to some embodiments, the mobile device [96] may be configured with reader means for reading indicia pertaining to a good or service [151]. According to some embodiments, the system application [147] may comprise a user prompt. According to some embodiments, the user prompt may comprise presenting an option to purchase the good or service [151] associated with the indicia for a contact or friend [145] of a user [91] associated with the mobile device [96]. According to some embodiments, the method may comprise a prompt presenting an option to accept the option to purchase the good or service [151] for the contact or friend [145]. According to some embodiments, the method may comprise the step of providing payment receiving software [100] for deducting funds or credits associated with a profile [130] associated with the user [91] associated with the mobile device [96]. According to some embodiments, the method may comprise the step of a prompt presenting an option to send information regarding the good or service [151] purchased by the user [91]; for example, via the user's [91] mobile device [96], to the contact or friend [145]. According to some embodiments, the method may comprise the step of a prompt presenting an option to send information regarding the good or service [151] to one or more of the group consisting of: a mobile device [96] associated with the contact or friend [145], an email address [49] associated with the contact or friend [145], and a profile [130] associated with the contact or friend [145]. According to some embodiments, if the step of sending the information regarding the good or service [151] to a profile [130] associated with the contact or friend [145] may be executed, the system application [147] may perform the step of posting information regarding the good or service [151] to the profile [130] directly, or through a third party application. According to some embodiments, the profile [130] may comprise a social network [93] profile.

A system adapted to assist a user [91] with shopping is further disclosed. According to some embodiments, the system may comprise a venue or location [2] and/or a vendor or selling entity [65] provided with a device configured to transmit a signal within a zone of proximity. According to some embodiments, the signal may comprise location information [143]. According to some embodiments, the system may comprise a mobile device [96] configured to receive the signal; for example, when the mobile device [96] enters the zone of proximity. According to some embodiments, the location information [143] may comprise layout information of a structure of the venue or location [2]. According to some embodiments, the location information [143] may comprise layout information of a structure of the vendor and/or selling entity [65]. According to some embodiments, the layout information may comprise an image of a layout of the structure of the venue or location [2]. According to some embodiments, the image of a layout may be provided on a positioning system user interface [106]. According to some embodiments, the positioning system user interface [106] may comprise advertising means [107]. According to some embodiments, the positioning system user interface [106] may comprise shopping list [144] information. According to some embodiments, the positioning system user interface [106] may comprise directional information relating to where to purchase an item on a shopping list [144]. According to some embodiments, the positioning system user interface [106] may comprise information relating to a favorable opinion [140] associated with a user [91] of the mobile device [96]. According to some embodiments, the favorable opinion [140] may comprise a “like” or a favorite [140] of the user [91] or a contact or friend [145] of the user [91]. According to some embodiments, the “like” or a favorite [140] may apply to the venue or location [2] and/or a vendor or selling entity [65] adjacent to or within the venue or location [2]. According to some embodiments, the layout information may comprise an image of a layout of the structure of the vendor or selling entity [65]. According to some embodiments, the image of a layout may be provided on a positioning system user interface [106]. According to some embodiments, the positioning system user interface [106] may comprise advertising means [107]. According to some embodiments, the advertising means [107] may comprise one or more advertisements; for example, in the form of indicia configured to advertise an item, product, good, or service. According to some embodiments, the one or more advertisements may comprise information regarding an offer, promotion, sale, coupon, discount, price, rating, or opinion [140] pertaining to a good or service [151]; for example, an offer, promotion, sale, coupon, discount, price, rating, or opinion [140] pertaining to a good or service which may be provided by the vendor or selling entity [65]. According to some embodiments, the system may comprise means for alerting a user with information regarding one or more of the group consisting of: an offer, a promotion, a sale, a coupon, a discount, a price, a rating, an opinion [140] pertaining to a good or service [151] provided by the vendor or selling entity [65], an on-your-shopping list [144] alert, a notification, and a you-have-credit alert [64]. According to some embodiments, the positioning system user interface [106] may comprise shopping list [144] information. According to some embodiments, the positioning system user interface [106] may comprise directional information relating to where to purchase an item on a shopping list [144]. According to some embodiments, the positioning system user interface [106] may comprise information relating to a favorable opinion [140] associated with a user [91] of the mobile device [96]. According to some embodiments, the favorable opinion [140] may comprise a “like” or a favorite [140] of the user [91] or a contact or friend [145] of the user [91]. According to some embodiments, the “like” or a favorite [140] may apply to the vendor or selling entity [65] or a good or service [151] located adjacent to or within the structure of the vendor or selling entity [65].

A method of providing consumer insight to a user [91] associated with a profile [130]; for example, providing consumer insight to a user [91] via a browser [131], is further disclosed. According to some embodiments, the method may comprise the step of providing a browser [131] configured to access information associated with the profile [130]. According to some embodiments, the method may comprise the step of displaying a redemption option regarding a purchasable good or service [151] via the browser [131]. According to some embodiments, the method may comprise the step of displaying, via the browser [131], indicia adjacent the at least one first redemption option. According to some embodiments, the indicia may comprise at least one of: a favorable opinion of a user [91] associated with the profile [130] and a favorable opinion of a contact, relative, or friend [145] of a user [91] associated with the profile [130]. According to some embodiments, the indicia may comprise at least one favorable opinion. According to some embodiments, the indicia may comprise at least one favorable opinion may comprise one or more of the group consisting of: a thumbs-up icon, alphanumeric indicia; for example, alphanumeric indicia comprising the word “LIKE” in a predetermined language, alpha-numeric indicia suggestive of a social media platform, alpha-numeric indicia suggestive of providing a favorable opinion, alpha-numeric indicia; for example, alpha-numeric indicia comprising the symbol “+”, and a heart-shaped icon. According to some embodiments, the indicia may comprise at least one of a favorable opinion may comprise a number. According to some embodiments, the number may comprise a total number of collective favorable opinions of a user [91] associated with the profile [130]. According to some embodiments, the total number of collective favorable opinions of a user [91] associated with the profile [130] may include favorable opinions of contacts, relatives, or friends [145] of the user [91] which may also be associated with the profile [130]. According to some embodiments, strangers to a user [91] associated with the profile, who are not a contact, relative, or friend [145] of a user [91] associated with the profile [130], may not provided to the indicia comprising at least one of a favorable opinion. For example, in some embodiments, a browser [131] associated with systems and methods disclosed herein may comprise one or more filters for a user [91] to filter out favorable opinions of strangers to the user [91] and show favorable opinions of contacts, relatives, or friends [145] of the user [91]. According to some embodiments, the indicia may comprise an avatar image. According to some embodiments, the avatar image may be associated with or suggestive of, a user [91] associated with the profile [130]. According to some embodiments, the avatar image may be associated with or suggestive of, a contact, relative, or friend [145] of a user [91] associated with the profile [130]. According to some embodiments, the avatar image may be configured to be interacted with by at least one of: pressing, touching, clicking, left-clicking, right-clicking, operatively engaging, tactilely engaging, dragging, or hovering a cursor over, the avatar image. According to some embodiments, when the avatar image is interacted with, the browser [131] may display a prompt. According to some embodiments, the prompt may provide an option to send the at least one first redemption option to an individual associated with the avatar image. According to some embodiments, when the avatar image is interacted with, the browser [131] may display a prompt providing an option to suggest the at least one first redemption option to an individual associated with the avatar image. According to some embodiments, when the avatar image is interacted with, the browser [131] may display a prompt providing an option to request the at least one first redemption option from an individual associated with the avatar image. According to some embodiments, when the avatar image is interacted with, the browser [131] may display a prompt providing an option to add the at least one first redemption option to a shopping list [144] of an individual associated with the avatar image. According to some embodiments, when the avatar image is interacted with, the browser [131] may display a prompt providing an option to add the at least one first redemption option to a gift list [144] for an individual associated with the avatar image. According to some embodiments, when the avatar image is interacted with, the browser [131] may display a prompt providing an option to post the at least one first redemption option to a profile [130] of an individual associated with the avatar image. According to some embodiments, the profile [130] of an individual associated with the avatar image may comprise a social network [93] profile.

A browser [131] for providing consumer insight to a user [91] associated with a profile [130] is disclosed. According to some embodiments, the browser [131] may be configured to access information associated with the profile [130] associated with the user [91]. According to some embodiments, the browser [131] may comprise a displayed redemption option regarding a purchasable good or service [151]. According to some embodiments, indicia may be displayed on the browser [131]; for example, on a page of the browser [131], adjacent the at least one first redemption option. According to some embodiments, the indicia may comprise at least one of: a favorable opinion of a user [91] associated with the profile [130] and a favorable opinion of a contact, relative, or friend [145] of a user [91] associated with the profile [130]. According to some embodiments, the indicia comprising at least one favorable opinion may comprise one or more of the group consisting of: a thumbs-up icon, alphanumeric indicia; for example, alphanumeric indicia comprising the word “LIKE” in a predetermined language, alpha-numeric indicia suggestive of a social media platform, alpha-numeric indicia suggestive of providing a favorable opinion, alpha-numeric indicia; for example, alpha-numeric indicia comprising the symbol “+”, and a heart-shaped icon. According to some embodiments, the indicia comprising at least one of a favorable opinion may comprise a number. According to some embodiments, the number may comprise a total number of collective favorable opinions of a user [91] associated with the profile [130]. According to some embodiments, the total number of collective favorable opinions of a user [91] associated with the profile [130] may include favorable opinions of contacts, relatives, or friends [145] of the user [91] which may also be associated with the profile [130]. According to some embodiments, strangers to a user [91] associated with the profile; for example, individuals who are not a contact, relative, or friend [145] of a user [91] associated with the profile [130], may not form a portion the indicia comprising at least one of a favorable opinion; for example, in some embodiments, the browser [131] may comprise one or more filters for a user [91] to filter out favorable opinions of strangers to the user [91] and show favorable opinions of contacts, relatives, or friends [145] of the user [91]. According to some embodiments, only those favorable opinions of contacts, relatives, or friends [145] of the user [91] may be shown. According to some embodiments, the indicia may comprise an avatar image. According to some embodiments, the avatar image may be associated with a user [91] associated with the profile [130] or a contact, relative, or friend [145] of a user [91] associated with the profile [130]. According to some embodiments, the avatar image may be configured to be interacted with by at least one of: pressing, touching, clicking, left-clicking, right-clicking, operatively engaging, tactilely engaging, dragging, or hovering a cursor over, the avatar image. According to some embodiments, the avatar image may be interacted with. According to some embodiments, when the avatar image is interacted with, the browser [131] may display a prompt. According to some embodiments, the prompt may include instructions which are suggestive of providing an option to send the at least one first redemption option to an individual associated with the avatar image. According to some embodiments, when the avatar image is interacted with, the browser [131] may display a prompt providing an option to suggest the at least one first redemption option to an individual associated with the avatar image. According to some embodiments, when the avatar image is interacted with, the browser [131] may display a prompt providing an option to request the at least one first redemption option from an individual associated with the avatar image. According to some embodiments, when the avatar image is interacted with, the browser [131] may display a prompt providing an option to add the at least one first redemption option to a shopping list [144] of an individual associated with the avatar image. According to some embodiments, when the avatar image is interacted with, the browser [131] may display a prompt providing an option to add the at least one first redemption option to a gift list [144] for an individual associated with the avatar image. According to some embodiments, when the avatar image is interacted with, the browser [131] may display a prompt providing an option to post the at least one first redemption option to a profile [130] of an individual associated with the avatar image. According to some embodiments, the profile [130] of an individual associated with the avatar image may comprise a social network [93] profile. According to some embodiments, the browser [131] may be provided to a website of a vendor or selling entity [65]. According to some embodiments, the browser [131] may be configured to be displayed on a mobile device [96] or computing device [95]. According to some embodiments, the browser [131] may be displayed on a display of mobile device [96] or computing device [95]; for example, a screen or projection of a mobile device [96] or computing device [95]. According to some embodiments, the browser [131] may be provided to a kiosk [3]; for example, pages of the browser [131] may be displayed on a screen or projection of a kiosk [3]. According to some embodiments, the browser [131] may be supported by a system application [147]. According to some embodiments, the browser [131] may comprise an add-in for the system application [147]; for example, for enabling the system application [147] to communicate with the browser [131]. According to some embodiments, the system application [147] may comprise an add-in for the browser [131]; for example, for enabling the system application [147] to communicate with the browser [131]. According to some embodiments, the browser [131] may be supported by a third-party application [148]. According to some embodiments, the browser [131] may comprise an add-in for the third-party application [148]; for example, for enabling the third-party application [148] to communicate with the browser [131]. According to some embodiments, the third-party application [148] may comprise an add-in for the browser [131]; for example, for enabling the third-party application [148] to communicate with the browser [131].

A method of advertising; for example, advertising to a user [91] associated with a profile [130] is further disclosed. According to some embodiments, the method may comprise the step of providing an icon. According to some embodiments, the icon may be associated with a good or service [151], a brand of good or service [151], or a vendor or selling entity [65]; for example, the icon may comprise a trademark. According to some embodiments, the method may comprise the step of providing an active link associated with the icon. According to some embodiments, the icon may be configured to be interacted with by at least one of: pressing, touching, clicking, left-clicking, right-clicking, operatively engaging, tactilely engaging, dragging, or hovering a cursor over the icon. According to some embodiments, when the icon is interacted with, a number of redemption options may be displayed; for example, displayed on a screen of a mobile device [96], computing device [95], and/or kiosk; for example, a screen or projection of a mobile device [96], computing device [95], and/or kiosk. According to some embodiments, the method may comprise the step of displaying a number of favorable opinions associated with the redemption options. According to some embodiments, the step of displaying a number of favorable opinions associated with the redemption options may occur when the icon is interacted with. According to some embodiments, the step of displaying a number of favorable opinions associated with the redemption options may comprise the step of displaying indicia. According to some embodiments, the indicia may be associated with or suggestive of the user [91] associated with the profile [130]; and/or the indicia may be associated with or suggestive of a contact, relative, or friend [145] of the user [91] associated with the profile [130]. According to some embodiments, the indicia may comprise one or more of the group consisting of: a thumbs-up icon, alpha-numeric indicia; for example, alpha-numeric indicia comprising the word “LIKE” in a predetermined language, alpha-numeric indicia suggestive of a social media platform, alpha-numeric indicia suggestive of providing a favorable opinion, alpha-numeric indicia; for example, alpha-numeric indicia comprising the symbol “+”, and a heart-shaped icon. According to some embodiments, the indicia may comprise a number. According to some embodiments, the number may comprise a total number of collective favorable opinions of the user [91] associated with the profile [130]. According to some embodiments, the total number of collective favorable opinions of the user [91] associated with the profile [130] may include one or more favorable opinions of contacts, relatives, or friends [145] of the user [91]. According to some embodiments, the one or more favorable opinions of contacts, relatives, or friends [145] of the user [91] may also be associated with the profile [130]. According to some embodiments, strangers to a user [91] associated with the profile; for example, individuals who are not a contact, relative, or friend [145] of a user [91] associated with the profile [130], may not be provided to the indicia. According to some embodiments, the indicia may comprise an avatar image. According to some embodiments, the avatar image may be associated with a user [91] associated with the profile [130] and/or a contact, relative, or friend [145] of a user [91] associated with the profile [130]. According to some embodiments, the avatar image may be configured to be interacted with by at least one of: pressing, touching, clicking, left-clicking, right-clicking, dragging, operatively engaging, tactilely engaging, or hovering a cursor over, the avatar image. According to some embodiments, the avatar image may be interacted with. According to some embodiments, when the avatar image is interacted with, the browser [131] may display a prompt. According to some embodiments, the prompt may include providing an option to send the at least one first redemption option to an individual associated with the avatar image. According to some embodiments, when the avatar image is interacted with, the browser [131] may display a prompt providing an option to suggest the at least one first redemption option to an individual associated with the avatar image. According to some embodiments, when the avatar image is interacted with, the browser [131] may display a prompt providing an option to request the at least one first redemption option from an individual associated with the avatar image. According to some embodiments, when the avatar image is interacted with, the browser [131] may display a prompt providing an option to add the at least one first redemption option to a shopping list [144] of an individual associated with the avatar image. According to some embodiments, when the avatar image is interacted with, the browser [131] may display a prompt providing an option to add the at least one first redemption option to a gift list [144] for an individual associated with the avatar image. According to some embodiments, when the avatar image is interacted with, the browser [131] may display a prompt providing an option to post the at least one first redemption option to a profile [130] of an individual associated with the avatar image. Where mentioned herein, the prompt may, according to some embodiments, be displayed on a page of, or a pop-up of, the browser, without limitation. According to some embodiments, the pop-up may comprise a pop-up window, a box, a bubble, or a separate page that may be displayed or projected; for example, displayed on a screen or projected onto a surface, without limitation. According to some embodiments, the page may comprise a web page, browser page, website page, display or projection created by a software command, and/or electronic page displayed by an application [147, 148], such as a system application [147] or a third-party application [148], without limitation. According to some embodiments, the profile [130] of an individual associated with the avatar image may comprise a social network [93] profile. According to some embodiments, the method may comprise the step of providing location data [143] adjacent the number of redemption options if and/or when the number of redemption options are displayed. According to some embodiments, the step of providing location data [143] may comprise displaying a distance and/or a unit of distance. According to some embodiments, the method may comprise the step of determining a current location of the user [91]. According to some embodiments, the step of determining a current location of the user [91] may be performed via a positioning technique. According to some embodiments, the distance may comprise a relative distance between the user [91] and the good or service [151], brand of good or service [151], or a vendor or selling entity [65] associated with the icon. According to some embodiments, the positioning technique may comprise one or more of the group consisting of: a network-based locating technique, a handset-based locating technique, an IP-address based locating technique, a SIM-based locating technique, a Wi-Fi-based locating technique, and a hybrid-based locating technique. According to some embodiments, the positioning technique may comprise a network-based technique. According to some embodiments, the network-based technique may comprise one or more of the group consisting of: cell identification, triangulation, and “Forward Link” positioning.

A method of combining dissimilar funds or credits is further disclosed. According to some embodiments, the method may be utilized to purchase a redemption option. According to some embodiments, the method may comprise the step of receiving a first input [4] credit regarding a first type of payment data [10]. According to some embodiments, the method may comprise the step of receiving a second input [4] credit regarding a second type of payment data [10]. According to some embodiments, the second type of payment data [10] may be different from the first type of payment data [10]. According to some embodiments, the method may comprise the step of determining a native value of the first and second input credits; for example, to define respective first and second native credit values in respective first and second units. According to some embodiments, the method may comprise the step of converting a selected one of the first and second input native credit values to the other of the first and second input native credit values; for example, by converting the selected one of the first and second units to the other of the first and second units. According to some embodiments, the method may comprise the step of adding the converted selected one of the first and second input native credit values and the other of the first and second input native credit values. According to some embodiments, the step of adding the converted selected one of the first and second input native credit values and the other of the first and second input native credit values may utilize a common unit. According to some embodiments, the method may comprise the step of purchasing the redemption option. According to some embodiments, the first type of payment data [10] and/or the second type of payment data [10] may be selected from one or more of the group consisting of: gift card [15]-based, eGift certificate-based, voucher-based, coupon-based, a redemption code-based credit, a ticket-based credit [75], a pass-based credit [67], a lottery ticket-based credit [82], a pawn ticket-based credit, a loan ticket based credit, a stock or tradable fund-based credit [81], pre-paid minutes-based credit [76], check-based credit [14], customer loyalty points-based credit [78], miles points-based credit, frequent diner points-based credit, cryptographic currency [18]-based credit, debit account-based credit [13], credit account-based credit [12], system account-based credit [17], receipt-based credit [20], and postage-based credit [25].

A system application [147] is further disclosed. According to some embodiments, the system application [147] may be utilized for facilitating gift giving. According to some embodiments, the application [147] may be configured to be installed on a mobile device [96] of a user [91] associated with a profile [130]. According to some embodiments, the system application [147] may be configured to access information associated with the profile [130] and perform the step of accessing information associated with the profile [130]. According to some embodiments, the information associated with the profile [130] may comprise or particularly comprise information regarding one or more contacts, relatives, or friends [145] associated with the profile [130]. According to some embodiments, the mobile device [96] may comprise audio input means [103]. According to some embodiments, the system application [147] may comprise voice recognition software; for example, voice recognition software which may be configured to receive and/or interpret audio inputs [7] made by the user [91]. According to some embodiments, the audio inputs [7] made by the user [91] may regard a desired recipient of funds, credits, or a redemption option. According to some embodiments, the system application may comprise means for comparing the audio inputs [7] made by a user [91] with information associated with the profile [130]. For example, according to some embodiments, the system application may comprise means for comparing the audio inputs [7] made by a user [91] with information associated with the profile [130] information associated with the profile [130] which may particularly comprise the information regarding one or more contacts, relatives, or friends [145] associated with the profile [130]. According to some embodiments, the system application may comprise means for presenting indicia; for example, indicia which may be representative or otherwise suggestive of the one or more contacts, relatives, or friends [145] of the user [91] which represent a closest match to audio inputs [7] made by a user [91]. According to some embodiments, the means for presenting indicia may comprise means for delivering image data [6] to a display or projection of the mobile device [96] and/or means for emitting audio data [7] from audio output means provided to the mobile device [96]. According to some embodiments, the system application may comprise means for accepting one or more audio-based [7] confirmation inputs [4] from the user [91]. According to some embodiments, the funds, credits, or a redemption option may comprise one or more of the group consisting of: cash [11], for example, in the form of electronic money; a ticket [75], a pass [67], a coupon [16], a redemption code, a gift card [15], a voucher, a lottery ticket [82], a pawn ticket, a loan ticket, stock or tradable fund [81], a credit card [12], pre-paid minutes [76], a check [14], customer loyalty points [78], miles points, frequent diner points, cryptographic currency [18], a credit to the second users [92] credit card account [12], a credit to the second user's [92] debit account [13], system account credit [17], a receipt [20], and postage [25]. According to some embodiments, the system application [147] may comprise payment receiving means [100] which may be selected from one or more of the group consisting of: electronic payment software, electronic funds transfer acceptance software, a secure checkout page [132], credit card account payment software, coupon code validation software, gift card validation software, a secure online payment submission webpage, a digital wallet client, a digital currency exchange client, payment due calculating software, credit adjusting software, account information updating software, a payment application, an NFC-compatible payment system, a digital mobile device payment application, remote deposit (capture) software, Check 21 Act-compliant online deposit software, Check 21 Act-compliant direct deposit software, and mobile deposit software.

A method of downloading or uploading information is further disclosed. According to some embodiments, the method may be advantageously utilized to download or upload information to a kiosk [3]. According to some embodiments, the method may comprise the step of providing an electronic address to the kiosk [3]; for example, a user [91] providing an electronic address to an entry field configured to receive and/or process electronic address information; wherein the electronic address may be entered by the user [91]. According to some embodiments, the entry field may be provided on, displayed on, or projected from the kiosk [3]. According to some embodiments, the step of providing an electronic address to the kiosk [3] may comprise displaying the electronic address on a display of the kiosk [3], or projecting the electronic address information from the kiosk [3]. According to some embodiments, the method may comprise the step of providing the electronic address to a user [91]. According to some embodiments, the method may comprise the step of the user [91] providing image data [6] and/or audio data [7] to the kiosk [3] via the electronic address. According to some embodiments, the electronic address may comprise a number. According to some embodiments, the method may comprise the step of the user [91] or a user [91] sending the image data [6] and/or audio data [7] via an SMS, MMS, or mobile messaging protocol to the number. According to some embodiments, the method may comprise the step of utilizing the number in an SMS, MMS, or mobile message; wherein the SMS, MMS, or mobile message may be created or otherwise made by the user [91]; for example, an SMS, MMS, or mobile message delivered by the user [91]. According to some embodiments, the number may be provided by the kiosk [3]; for example, provided to the kiosk [3], or displayed on or otherwise projected from the kiosk [3]. According to some embodiments, the number may be provided by a system website [127]; for example, provided to a system website [127], or displayed on a system website [127]. According to some embodiments, the number may be provided by a system application [147]; for example, provided to a system application [147], displayed via a system application [147], or projected from a system application [147]. According to some embodiments, the number may be provided by a third-party application [148]; for example, provided to a third-party application [148], displayed via a third-party application [148], or projected from a third-party application [148]. According to some embodiments, the electronic address may comprise unique profile [130] information. According to some embodiments, the method may comprise the user [91] sending the image data [6] and/or audio data [7] to the profile [130]; for example, via a system application [147]. According to some embodiments, the electronic address may comprise unique profile [130] information. According to some embodiments, the method may comprise the user [91] sending the image data [6] and/or audio data [7] to the profile [130]; for example, via a third-party application [148]. According to some embodiments, the unique profile [130] information may be provided by the kiosk [3]; for example, provided to the kiosk [3], or displayed on or otherwise projected from the kiosk [3]. According to some embodiments, the unique profile [130] information may be provided by a system website [127]; for example, provided to a system website [127], or displayed on a system website [127]. According to some embodiments, the unique profile [130] information may be provided by a system application [147]; for example, provided to a system application [147], displayed via a system application [147], or projected from a system application [147]. According to some embodiments, the unique profile [130] information may be provided by a third-party application [148]; for example, provided to a third-party application [148], displayed via a third-party application [148], or projected from a third-party application [148]. According to some embodiments, the unique profile [130] information may comprise a social network [93] profile or information pertaining to a social network [93] profile. According to some embodiments, the method may comprise the step of the user [91] sending a post (e.g., a “Tweet”, using the Twitter® social media platform, or a post using the Facebook® social media platform) to the social network profile [130]. According to some embodiments, the post may contain one or more portions, some portions, or all portions of the image data [6] and/or audio data [7]. According to some embodiments, the step of the user [91] sending a post may comprise the user [91] sending the post; for example, sending the post to an electronic address which may comprise the character “@”. According to some embodiments, the post may comprise a URL or link to a server [125, 128, 136], social network site [93], system website, third-party website, or disk storage device; for example, a server [125, 128, 136], social network site [93], system website, third-party website, or disk storage device containing or otherwise storing the image data [6] and/or audio data [7]. According to some embodiments, the disk storage device may comprise disk or drive memory provided to a mobile device [96] or a computing device [95]. According to some embodiments, the computing device [95] may comprise a kiosk [3] which may be the same, or different from the aforementioned kiosk [3] described above. According to some embodiments, the method may comprise the step of providing the kiosk [3] with hardwire link means [114]. According to some embodiments, the hardware link means [114] may be configured to physically connect with a mobile device [96]. For example, according to some embodiments, the hardware link means [114] may comprise one or more connectors which are configured to connect to a mobile device [96] directly, and/or indirectly (e.g., using an adapter, connector cable, or the like). According to some embodiments, the method may comprise the step of connecting a mobile device [96] with the hardwire link means [114]. According to some embodiments, the hardwire link means [114] may comprise, without limitation, a device selected from one or more of the group consisting of: a parallel port, a general purpose interface bus GPIB, a cable connector, a small computer system interface SCSI (e.g., ISIS), a universal serial bus (USB) connector, a FireWire connector, a proprietary interface, an applications programming interface API, a SANE device, a TWAIN device, and a Windows image acquisition WIA device. According to some embodiments, the hardwire link means [114] may be used to connect with an electronic device which may comprise payment data [10] and/or user data [10]. According to some embodiments, the method may comprise the step of providing the kiosk [3] with reader means [110]; for example, reader means [110] which may be configured to wirelessly connect with a mobile device [96]. According to some embodiments, the reader means may be configured to send wireless communications, e.g., wireless communications comprising data, between the kiosk [3] and the mobile device [96]. According to some embodiments, data contained within the wireless communications may comprise payment data [10] and/or user data [10]. According to some embodiments, the method may comprise the step of presenting a mobile device [96] within a reading zone of proximity from the reader means [110]. According to some embodiments, the reader means [110] may be configured to receive and/or deliver wireless signals via near field communication (NFC) protocol. According to some embodiments, the step of presenting a mobile device [96] within a reading zone of proximity from the reader means [110] may comprise presenting a mobile device [96] configured to send and receive wireless signals via near field communication (NFC) protocol; for example, a mobile device [96] which may comprise hardware and/or software required for making NFC-based communications.

A method of personalizing a card [19] is further disclosed. According to some embodiments, the method may comprise the step of a user [91] approaching a kiosk [3]. According to some embodiments, the method may comprise the step of the user [91] providing payment data [10] as an input [4] to the kiosk [3]. According to some embodiments, the method may comprise the step of the user [91] providing image data [6] as an input [4] to the kiosk [3]. According to some embodiments, the method may comprise the step of the kiosk [3] producing a custom card [19]. According to some embodiments, the indicia may comprise at least a portion of the image data [6]. According to some embodiments, the method may comprise the step of the kiosk [3] dispensing the card [19] to the user [91]. According to some embodiments, the method may comprise the step of printing one or more portions of the indicia on a card blank. According to some embodiments, the method may comprise the step of printing some portions of the indicia on a card blank. According to some embodiments, the method may comprise the step of printing the indicia on a card blank. According to some embodiments, the method may comprise the step of printing all portions of the indicia on a card blank. According to some embodiments, the card blank may comprise a template having template indicia thereon. According to some embodiments, the card blank may comprise a template having template indicia already thereon. According to some embodiments, the card blank may comprise a designated printing area. According to some embodiments, the card blank may comprise one or more of the group consisting of: a chip [86], an RFID device [88], alphanumeric text or characters [89], a barcode [79], a magnetic stripe [87], a solid state device [85], advertising [107] information, and image information [77]. According to some embodiments, the indicia may comprise at least one of the group consisting of: a message [41], a design [42], a stock image [38], a user name [47], a 1D barcode, a 2D barcode, a data matrix code, a QR code, an image, a graphic, printed matter, text, an alphanumeric code, a photo, a logo, indicia, a brand, trade dress, a trademark, user data, a color, a puzzle, a visual game, and word art. According to some embodiments, the card [19] may be selected from one or more of the group consisting of: a cash card [11], a ticket [75] card, a pass [67] card, a coupon [16] card, a redemption code card, a gift card [15], a voucher card, a lottery ticket [82] card, a pawn ticket card, a loan ticket card, stock or tradable fund [81] card, a credit card [12], a pre-paid minutes [76] card, a check [14] card, a customer loyalty points [78] card, a miles points card, a frequent diner points card, a cryptographic currency [18] card, a system account [17] card, and a postage [25] card. According to some embodiments, the card [19] may have one or more functions for which the card [19] may be utilized. For example, according to some embodiments, the card [19] may be utilized for one or more of the functions selected from the group consisting of: a cash card [11], a ticket [75] card, a pass [67] card, a coupon [16] card, a redemption code card, a gift card [15], a voucher card, a lottery ticket [82] card, a pawn ticket card, a loan ticket card, stock or tradable fund [81] card, a credit card [12], a pre-paid minutes [76] card, a check [14] card, a customer loyalty points [78] card, a miles points card, a frequent diner points card, a cryptographic currency [18] card, a system account [17] card, and a postage [25] card.

A method of personalizing a card [19] is also disclosed. According to some embodiments, the method may comprise the step of a user [91] approaching a kiosk [3]. According to some embodiments, the method may comprise the step of a user selecting at least one of a group of card blanks having different indicia thereon; wherein the group of card blanks having different indicia thereon may be displayed on a display of the kiosk [3], or otherwise projected from the kiosk [3]. For example, according to some embodiments, the group of card blanks having different indicia thereon may be displayed on a screen provided to the kiosk [3]. According to some embodiments, the method may comprise the step of the user [91] providing payment data [10] as an input [4] to the kiosk [3]. According to some embodiments, the method may comprise the step of the user [91] providing a message [41] and/or recipient user data [8], such as a recipient name [47] and/or other recipient user data [8], as an input [4] to the kiosk [3]. According to some embodiments, the method may comprise the step of printing the message [41] and/or recipient user data [8], such as a recipient name [47] and/or other recipient user data [8], on a card blank. According to some embodiments, the method may comprise the step of the user [91] providing a message [41] and/or user data [8] of the user [91], such as a name [47] and/or other user data [8] pertaining to the user [91], as an input [4] to the kiosk [3]. According to some embodiments, the method may comprise the step of printing the message [41] and/or recipient user data [8], user data [8] of the user [91], such as a name [47] and/or other user data [8] pertaining to the user [91], on a card blank. According to some embodiments, a method of producing a custom card [19] may comprise indicia; for example, indicia regarding at least a portion of the message [41] and/or recipient user data [8]. According to some embodiments, the indicia may, for example, comprise indicia regarding at least a portion of the message [41] and/or user data [8] associated with the user [91]. According to some embodiments, the user data [8] may comprise a recipient name [47] and/or the user's [91] name. According to some embodiments, the method may comprise the kiosk [3] dispensing the card [19] to the user [91]. According to some embodiments, the method may comprise the kiosk [3] electronically delivering the card [19] to a recipient's mobile device [96] or computing device [95] using any one or more of the communication protocols or platforms described herein (e.g., via system website, via third-party website, via a social media platform, via a vendor/entity website, via email, via SMS, MMS, or mobile messaging platform, via a system application [147], via a third-party system application [148], etc.). According to some embodiments, the recipient's mobile device [96] or computing device [95] may be the user's [91] mobile device [96] or computing device [95], or a mobile device [96] or computing device [95] of one or more individuals which are not the user [91]. According to some embodiments, the method may comprise the step of electronically displaying the group of card blanks having different indicia thereon, as a digital image on display means [109] provided to the kiosk [3]. According to some embodiments, the method may comprise the step of physically displaying, for example, adjacent to or on the kiosk [3], the group of card blanks having different indicia thereon, and/or images (e.g., decals or printed matter) indicative of the group of card blanks having different indicia thereon. For example, a stack of physical card blanks representing some or all of the group of card blanks may be provided in a container adjacent to or provided on the kiosk [3]. According to some embodiments, the user [91] may select a card blank [91]; for example, by selecting one or more of the card blanks provided in a container adjacent to or provided on the kiosk [3], and/or taking or otherwise removing the one or more selected card blanks from a container adjacent to or provided on the kiosk [3]. According to some embodiments, the user [91] may present a selected card blank [91] to the kiosk [3]; for example, for processing of the selected card blank [91] by the kiosk [3].

A method of personalizing and/or customizing one or more existing cards and/or combining multiple existing cards onto a single new card [19] is further disclosed. According to some embodiments, the method may comprise the step of a user [91] approaching a kiosk [3]. According to some embodiments, the method may comprise the step of the user selecting stock [38] image data [6] provided by display means [109], and/or providing image data [6] to the kiosk [3]. According to some embodiments, the method may comprise the step of the user [91] providing one or more inputs [4] to the kiosk [3]; for example, one or more inputs [4] regarding the one or more existing cards. The one or more inputs [4] regarding the one or more existing cards may comprise user data [8] and/or payment data [10], without limitation. According to some embodiments, the user data [8] and/or payment data [10] associated with the one or more inputs [4] may relate to the same user [91], or one or more different individuals which may or may not comprise the same user [91] completing the step of approaching the kiosk [3].

According to some embodiments, the method may comprise the step of the kiosk [3] writing or otherwise transferring information associated with the one or more inputs [4] regarding the one or more existing cards; for example, transferring information associated with the one or more inputs [4] regarding the one or more existing cards to a card blank. According to some embodiments, the method may comprise the step of the kiosk [3] dispensing the new card [19] to the user [91]. According to some embodiments, the method may comprise the kiosk [3] electronically delivering the new card [19] to a recipient's mobile device [96] or computing device [95] using any one or more of the communication protocols or platforms described herein (e.g., via system website, via third-party website, via a social media platform, via a vendor/entity website, via email, via SMS, MMS, or mobile messaging platform, via a system application [147], via a third-party system application [148], etc.). According to some embodiments, the recipient's mobile device [96] or computing device [95] may be the user's [91] mobile device [96] or computing device [95], or a mobile device [96] or computing device [95] of one or more individuals which are not the user [91]. According to some embodiments, the step of the kiosk [3] writing or otherwise transferring information may comprise the step of printing indicia to the card blank, and/or digitally writing information to the card blank. According to some embodiments, the method may comprise electronically displaying the group of card blanks having different indicia thereon as a digital image on display means [109] provided to the kiosk [3].

Further disclosed, is a card [19]. According to some embodiments, the card [19] may be configured to be utilized as a reusable gift card and/or as a reusable promotional card [19]. According to some embodiments, the card [19] may comprise one or more of the devices selected from the group consisting of: a chip [86], an RFID device [88], and a solid state device [85].

Further disclosed, is a card blank. According to some embodiments, the card blank may comprise a reusable card blank. According to some embodiments, the reusable card blank may be configured for being customized by a kiosk [3]. According to some embodiments, the card blank may comprise one or more of the devices selected from the group consisting of: a chip [86], an RFID device [88], and a solid state device [85]. According to some embodiments, the card blank may comprise template indicia thereon. According to some embodiments, the card blank may comprise an area thereon for printed matter to be applied and/or re-applied. For example, according to some embodiments, the area for printed matter to be applied and/or re-applied may be fully or partially-free or clear of indicia. According to some embodiments, the area for printed matter to be applied and/or re-applied may comprise a matte, semi-glossy, or glossy surface. According to some embodiments, the area thereon for printed matter to be applied and/or re-applied may be configured to receive a sticker applied thereto. According to some embodiments, the area thereon for printed matter to be applied and/or re-applied may be occupied by a sticker applied thereto. According to some embodiments, the sticker applied thereto may be configured to be printed by a kiosk [3] or conveyed from a roll of pre-printed stickers contained within a kiosk [3]. According to some embodiments, the sticker applied thereto may be dispensed by a kiosk [3]. According to some embodiments, the sticker applied thereto may be applied to the card blank by the kiosk [3]. According to some embodiments, the sticker applied thereto may be applied to the card blank by a person adjacent the kiosk [3]; for example, may be applied to the card blank by a user [91] of the kiosk [3] which may be operating or functionally communicating with the kiosk [3]. According to some embodiments, the sticker may comprise redemption data [64] and/or payment data [10]. According to some embodiments, the sticker may comprise user data [8] of the user [91] and/or user data [8] affiliated with an intended recipient of a card [19] produced from the card blank. According to some embodiments, portions of, or all of the redemption data [64] and/or payment data [10] may be in the form of a 1D barcode, 2D barcode, QR code, or data matrix code. According to some embodiments, the card blank may comprise personalized indicia thereon. According to some embodiments, the personalized indicia may be provided to the card blank; for example, provided to the card blank via a kiosk [3], or a user [91] applying the personalized indicia to the card blank.

A shopper card [19] or loyalty card [19] is further disclosed. According to some embodiments, the shopper card [19] or loyalty card [19] may comprise one or more of the devices selected from the group consisting of: a chip [86], an RFID device [88], and a solid state device [85]. According to some embodiments, the shopper card [19] or loyalty card [19] may be configured to support digital promotions, coupons, funds, or credits from: various non-affiliated vendors and/or various non-affiliated selling entities [65].

According to some embodiments, the shopper card [19] or loyalty card [19] may comprise template indicia thereon. According to some embodiments, the shopper card [19] or loyalty card [19] may comprise an area thereon for printed matter to be applied and/or re-applied. According to some embodiments, the area thereon for printed matter to be applied and/or re-applied may be configured to receive a sticker applied thereto. According to some embodiments, the sticker applied thereto may be configured to be printed and dispensed by a kiosk [3] or other printing device. According to some embodiments, the sticker may comprise redemption data [64] and/or payment data [10]. According to some embodiments, the redemption data [64] and/or payment data [10] may be in the form of one or more of the following: a 1D barcode, a 2D barcode, a QR code, a data matrix code. According to some embodiments, the 1D barcode, 2D barcode, QR code, and data matrix code may comprise a first ink, which may be visible in a first wavelength of light, and a second ink which may be invisible in the first wavelength of light and visible in a second wavelength of light. According to some embodiments, the first wavelength of light may be in the UV or infrared spectrum, and the second wavelength of light may be in the visible spectrum. According to some embodiments, the second ink may be applied over the first ink. According to some embodiments, shopper card [19] or loyalty card [19] may comprise personalized indicia thereon.

According to some embodiments, other types of cards [19] (e.g., gift cards, pre-paid cards, and payment cards such as debit cards, credit cards which are disclosed herein, without limitation) may comprise 1D barcode, 2D barcode, QR code, or data matrix code which may comprise a first ink, which may be visible in a first wavelength of light, and a second ink which may be invisible in the first wavelength of light and visible in a second wavelength of light. For example, according to some embodiments, the first wavelength of light may be in the UV or infrared spectrum, and the second wavelength of light may be in the visible spectrum. According to some embodiments, the second ink may be applied over the first ink. According to some embodiments, the 1D barcode, 2D barcode, QR code, or data matrix code may comprise redemption data [64], user data [8], and/or payment data [10]. According to some embodiments, the 1D barcode, 2D barcode, QR code, or data matrix code may comprise information which may not only be encoded (i.e., into a machine-readable indicia format), but also encrypted in part, or in whole. In such embodiments where the information contained within the 1D barcode, 2D barcode, QR code, or data matrix code is encrypted, a terminal, such as a payment terminal [100] and/or payment receiving means [100] which may be provided with means for decrypting the information. For example, according to some embodiments, the means for decrypting the information may comprise decoding software (e.g., for decoding the 1D barcode, 2D barcode, QR code, or data matrix code) and/or decrypting software (e.g., for decrypting the encrypted information stored within the 1D barcode, 2D barcode, QR code, or data matrix code). According to some embodiments, the decoding software and/or decrypting software may be installed on the payment terminal [100] and/or other payment receiving means [100], or a server communicating with the payment terminal [100] and/or other payment receiving means [100]; for example, communicating over a network [93] with the payment terminal [100] and/or other payment receiving means [100].

An electronic gift is further disclosed. According to some embodiments, the electronic gift may comprise a message [41] and/or image data [6].

A method of purchasing a lottery ticket [82] for another individual is further disclosed. For example, the method may comprise a first user [91] purchasing a lottery ticket [82] for a second user [92]. According to some embodiments, the method may comprise the step of purchasing a lottery ticket [82] via a system website [127], a system application [147], or a system kiosk [3]. According to some embodiments, the method may comprise the step of selecting a recipient of the lottery ticket [82]. According to some embodiments, the method may comprise the step of storing information relating to the lottery ticket in a system database [128]. According to some embodiments, the method may comprise the step of the recipient redeeming the lottery ticket [82] via the system website [127], a system application [147], or a system kiosk [3].

A reader communicating with a payment terminal [100] or other payment receiving means [100] may, according to some embodiments, comprise a code scanner [102]. According to some embodiments, a reader communicating with a payment terminal [100] may comprise first wavelength emitting means [102a] provided to or adjacent the code scanner. According to some embodiments, the reader may be configured to read a code under different wavelengths of light. According to some embodiments, the reader may be configured to read the same code under different wavelengths of light. According to some embodiments, the different wavelengths of light may comprise one or more wavelengths of visible light and one or more of the group consisting of: one or more wavelengths of infrared light, and one or more wavelengths of ultraviolet light. According to some embodiments, the code may comprise a 1D barcode, 2D barcode, QR code, or a data matrix code. According to some embodiments, the 1D barcode, 2D barcode, QR code, or data matrix code may comprise a first ink, which may be visible in the first wavelength of light, and a second ink which may be invisible in the first wavelength of light and visible in a second wavelength of light. According to some embodiments, the first wavelength of light may be in the ultraviolet and/or infrared spectrum, and the second wavelength of light may be in the visible spectrum. According to some embodiments, the second ink may be applied over the first ink. According to some embodiments, the first ink may be applied over the second ink. According to some embodiments, (for example, in instances where the second ink may be applied over the first ink) under visible light (e.g., in the presence of visible light), the second ink applied over the first ink may comprise a second 1D barcode, 2D barcode, QR code, or data matrix code containing second information when read by the scanner [102]. According to some embodiments, when the first wavelength emitting means [102a] may emit or be configured to emit, a first wavelength of light, wherein the first ink (e.g., the first ink applied beneath the second ink, without limitation) may comprise a first 1D barcode, 2D barcode, QR code, or data matrix code containing first information when read by the scanner [102]. According to some embodiments, the reader may comprise additional wavelength emitting means, such as second wavelength emitting means, third wavelength emitting means, and/or fourth wavelength emitting means, etc., which may emit or be configured to emit, respective second, third, and fourth wavelengths of light, etc. According to some embodiments, the second, third, and/or fourth wavelengths of light may be different. According to some embodiments, the second, third, and/or fourth wavelengths of light may be in the non-visible spectrum of light. According to some embodiments, the second, third, and/or fourth wavelengths of light may be configured to work with third, fourth, and/or fifth inks configured to be visible within the second, third, and/or fourth wavelengths of light, respectively. Accordingly, while the drawings accompanying this specification and/or co-pending applications to which this application claims priority may only explicitly show a code utilizing two inks, it is envisaged that some embodiments may comprise codes which utilize a number of different inks which are visible in a number of different wavelengths of light. Moreover, it is envisaged that some embodiments of a reader may comprise more than one, or a plurality of wavelength emitting means, wherein each of the wavelength emitting means may emit or otherwise be configured to emit different wavelengths of light. According to some embodiments, third, fourth, or fifth inks may be utilized with a code to be read by the reader, wherein any one or more of the inks may comprise its own 1D barcode, 2D barcode, QR code, or data matrix code containing second information when read by the scanner [102]. According to some embodiments, the first, second, third, and/or fourth wavelength emitting means may cycle through a number of different wavelengths associated with the different inks; for example, to read indicia printed in the different inks which are visible in the number of different wavelengths, respectively. Accordingly, the reader may be configured to extract different layers of information with respect to a code. According to some embodiments, the second information may contain redemption data [64], and the first information may comprise one or more security features [99], such as one or more verification codes and/or one or more authentication codes. According to some embodiments, the second information may contain redemption data [64] and the first information may comprise user data [8]. According to some embodiments, the first information and/or the second information may contain payment data [64]. According to some embodiments, the information contained within indicia printed with any one of the aforementioned inks may contain payment data [64]. According to some embodiments, the reader may be configured to display on the terminal, the user data [8], wherein an operator of the reader may utilize the user data [8] to verify the redemption data [64]. According to some embodiments, the operator of the reader may utilize the user data [8] to request identification from a first user [91]; for example, to see or otherwise determine if it matches the user data [8]. According to some embodiments, the user data [8] may comprise phone number information, wherein the payment terminal [100] may be configured to send an authorization code to a mobile device [96] associated with the phone number information. For example, to a mobile device [96] of a user [91] making a transaction using the reader. According to some embodiments, the user data [8] may comprise account information; for example, account information associated with a user [91] making a transaction using the reader, and/or account information associated with a user [91] other than a user [91] making a transaction using the reader. According to some embodiments, the payment terminal [100] may be configured with data input means [117] which may be utilized to receive the authorization code from a user [91] presenting the code.

A redemption card [19] is also disclosed. According to some embodiments, the redemption card may be configured to be loaded with a plurality of redemption options. According to some embodiments, some of the plurality of redemption options may not necessarily be redeemable at certain first vendors or entities [65]. According to some embodiments, some of the plurality of redemption options may be redeemable at certain second vendors or entities [65]. According to some embodiments, the redemption card [19] may be configured to be used at the first and second certain vendors or entities [65]. According to some embodiments, the plurality of redemption options may comprise at least one of the following: store credit, coupons, promotions, offers, specials, deals. According to some embodiments, the plurality of redemption options may comprise at least one one-time redemption option; wherein the plurality of redemption options may be loaded to the redemption card [19]; and wherein once the one-time redemption option may be used or otherwise redeemed, it may be unloaded from the redemption card [19]. According to some embodiments, the redemption card [19] may comprise at least one of the group consisting of: a gift card [15], a cash [11] card, a ticket [75], a pass [67], a coupon [16], a redemption code, a voucher, a lottery ticket [82], a pawn ticket, a loan ticket, stock or tradable fund [81] information, a credit card [12], pre-paid minutes [76], check [14] funds, customer loyalty points [78], miles points, frequent diner points, cryptographic currency [18], system account credit [17], an arbitrary currency credit, a receipt [20], and postage [25].

A gift card [19] is further disclosed. According to some embodiments, the gift card [19] may comprise pre-paid voucher information. According to some embodiments, the voucher information may comprise a number of redemption options. According to some embodiments, the gift card [19] may be used to redeem at least one of the number of redemption options from at least one of a number of nonaffiliated vendors or entities [65]. According to some embodiments, the number of redemption options may comprise a plurality of redemption options which may be of similar value. According to some embodiments, the redemption options may relate to different brands of goods or services [151] which are not affiliated with each other, different goods or services [151] which are not affiliated with each other, or different vendors or entities [65] which are not affiliated with each other. According to some embodiments, the gift card [19] may be configured to be used more than once; for example, to redeem a plurality of the number of redemption options. According to some embodiments, the gift card [19] may only be used once to redeem one or more of the number of redemption options. According to some embodiments, the gift card [19] may be produced from a kiosk [3]. According to some embodiments, the number of redemption options may be provided by a system application [147] or a third-party application [148]. According to some embodiments, the number of redemption options may be provided via a social network [93]. According to some embodiments, the number of redemption options may be provided by a social network [93] website. According to some embodiments, the number of redemption options may be provided by a social network [93] application. According to some embodiments, the gift card [19] may be associated with a profile [130] of a user [91] of the gift card [19]. According to some embodiments, the profile [130] may comprise a system profile. According to some embodiments, the profile [130] may comprise a social network [93] profile. According to some embodiments, contacts, relatives, or friends [145] associated with the profile [130] may remotely add redemption options to the gift card [19]. According to some embodiments, contacts, relatives, or friends [145] associated with the profile [130] may remotely add redemption options to the gift card [19] by posting the redemption option to the user's profile [130]; for example, posting the redemption option to the user's profile [130] using a mobile [96] or computing device [95]. According to some embodiments, the step of sending the redemption option to the user's profile [130] may comprise sending a message or post to the user's profile [130]; for example, such as a “Tweet” via the Twitter® social media platform).

A friend card [19] is further disclosed. According to some embodiments, the friend card [19] may be associated with a profile [130] of a user [91]. According to some embodiments, the friend card [19] may be configured to hold information pertaining to funds, credits, or pre-paid redemption options. According to some embodiments, the friend card [19] may be used to redeem the funds, credits, or pre-paid redemption options at a number of non-affiliated vendors or entities [65]. According to some embodiments, at least some of the funds, credits, or pre-paid redemption options may be delivered to the friend card [19] via one or more of the group consisting of: a system kiosk [3], a system application [147], a system website [127], a third-party application [148], and a social network [93]. According to some embodiments, the pre-paid redemption options may relate to: different brands of goods or services [151] which are not affiliated, different goods or services [151] which are not affiliated, and/or different vendors or entities [65] which are not affiliated. According to some embodiments, the friend card [19] may be used more than once to redeem a plurality of the pre-paid redemption options; e.g., the friend card [19] may be reusable and/or re-loadable. According to some embodiments, the friend card [19] may be produced from a kiosk [3]. According to some embodiments, at least some of the funds, credits, or prepaid redemption options may be delivered to the profile [130] from one or more contacts, relatives, or friends [145] associated with the profile [130]. According to some embodiments, the one or more contacts, relatives, or friends [145] associated with the profile [130] may be contacts, relatives, or friends [145] of the user [91]. According to some embodiments, the contacts, relatives, or friends [145] of the user [91] of the friend card [19] may be contacts, relatives, or friends [145] of the user on a social network [93]. According to some embodiments, the funds, credits, or pre-paid redemption options may be provided by a system application [147] or a third-party application [148]. According to some embodiments, the funds, credits, or pre-paid redemption options may be provided to the friend card [19] via a social network [93]. According to some embodiments, the funds, credits, or pre-paid redemption options may be provided by a social network [93] website. According to some embodiments, the funds, credits, or pre-paid redemption options may be purchased through a social network [93] website. According to some embodiments, the funds, credits, or pre-paid redemption options may be purchased and applied or otherwise associated with the friend card [19] through a social network [93] application. According to some embodiments, the profile [130] may comprise a system profile. According to some embodiments, the profile [130] may comprise a social network [93] profile. According to some embodiments, contacts, relatives, or friends [145] associated with the profile [130] may remotely add redemption options to the friend card [19].

According to some embodiments, contacts, relatives, or friends [145] associated with the profile [130] may remotely add redemption options to the gift card [19]; for example, by posting the funds, credits, or pre-paid redemption options to the profile [130]. According to some embodiments, the funds, credits, or pre-paid redemption options may be posted to the profile [130] using a mobile [96] or computing device [95]. According to some embodiments, the step of sending the funds, credits, or pre-paid redemption options to the user's profile [130] may comprise the step of sending a message or post to the user's profile [130] (e.g., a “Tweet” via the social media platform Twitter®, or a post via the social media platform Facebook®, without limitation).

A digital wallet is further disclosed. According to some embodiments, the digital wallet may be associated with a social network [93] profile [130]. According to some embodiments, the digital wallet may comprise one or more funds, credits, or pre-paid redemption options. According to some embodiments, the one or more funds, credits, or pre-paid redemption options may be configured to be provided to the digital wallet; for example, by a contact, relative, or friend [145] associated with the social network [93] profile [130]. According to some embodiments, the digital wallet may be configured to be provided to a mobile device [96] or a computing device [95]. According to some embodiments, the digital wallet may be supported by a system application [147]. According to some embodiments, the system application [147] may comprise means for accessing one or more of the funds, credits, or pre-paid redemption options contained within the digital wallet. According to some embodiments, the system application [147] may comprise means for displaying one or more of the funds, credits, or pre-paid redemption options contained within the digital wallet; for example, on display means [109] provided on the mobile [96] or computing [95] device. According to some embodiments, the system application [147] may comprise means for alerting a user [91] of the digital wallet; for example, means for alerting a user [91] of the digital wallet that one or more of the funds, credits, or pre-paid redemption options have been added to the digital wallet. According to some embodiments, the system application [147] may comprise a third-party application [148]. According to some embodiments, the digital wallet may be supported by a third-party application [148]. According to some embodiments, the system application [147] may comprise a social network [93]-based application. According to some embodiments, a user [91] of the digital wallet may send funds, credits, or pre-paid redemption options to contacts, relatives, or friends [145] associated with the profile [130]. According to some embodiments, a user [91] of the digital wallet may purchase pre-paid redemption options using the social network [93]-based application. According to some embodiments, a user [91] of the digital wallet may send purchased pre-paid redemption options to one or more contacts, relatives, or friends [145] associated with the profile [130]; for example, a user [91] of the digital wallet may send purchased pre-paid redemption options to one or more contacts, relatives, or friends [145] associated with the profile [130] using the social network [93]-based application supporting the digital wallet. According to some embodiments, the digital wallet may be provided to a mobile device [96], wherein the system application [147] may support near field communication (NFC) protocol. According to some embodiments, the digital wallet may be provided to a mobile device [96], wherein the system application [147] may be configured to display indicia pertaining to the funds, credits, or pre-paid redemption options. According to some embodiments, the indicia pertaining to the funds, credits, or pre-paid redemption options may comprise one or more of the group consisting of: a 1D barcode, a 2D barcode, a digital matrix code, and a QR code. According to some embodiments, the system application [147] may be configured to display the indicia pertaining to the funds, credits, or pre-paid redemption options on a display of a mobile device [96]. According to some embodiments, the social network [93]-based application may comprise means for displaying indicia relating to a contact, relative, or friend [145] associated with the profile [130]. According to some embodiments, the indicia relating to a contact, relative, or friend [145] associated with the profile [130] may comprise indicia associated with a profile [130] of a contact, relative, or friend [145]; for example, a contact, relative, or friend [145] of a user [91] of the system application [147] and/or a user [91] of the digital wallet. According to some embodiments, the indicia associated with a profile [130] of a contact, relative, or friend [145] may comprise a name of the contact, relative, or friend [145]. According to some embodiments, the indicia associated with a profile [130] of a contact, relative, or friend [145] may comprise an avatar image of the contact, relative, or friend [145]. According to some embodiments, the indicia associated with a profile [130] of a contact, relative, or friend [145] may comprise a favorable opinion of the contact, relative, or friend [145]. According to some embodiments, the favorable opinion of the contact, relative, or friend [145] may comprise one or more of the group consisting of: the word “like”, the word “likes”, a thumbs-up icon, the character “+”, the character “@”, the character “#”, an icon indicative of a social media platform function, an icon indicative of a social media platform action, and a heart-shaped icon. According to some embodiments, the system application [147] may be configured to display the favorable opinion of the contact, relative, or friend [145]; for example, the system application [147] may be configured to display the favorable opinion of the contact, relative, or friend [145] next to one or more of the group consisting of: a fund, a credit, a pre-paid redemption option, and a redemption option available for purchase.

A gift card [19] is further disclosed. According to some embodiments, the gift card [19] may be redeemable for a specific brand of good or service [151], and/or a specific good or service [151]. According to some embodiments, the specific brand of good or service [151], and/or the specific good or service [151] may be redeemable at a plurality of vendors or entities [65] which may not be affiliated with each other. For example, according to some embodiments at least two of the plurality of vendors or entities [65] may not be affiliated with each other. According to some embodiments, the gift card may comprise a plurality of redeemable options; wherein at least one of the plurality of redeemable options may pertain to a specific brand of good or service [151], or a specific good or service [151]. According to some embodiments, the gift card may comprise custom indicia. According to some embodiments, the gift card may comprise a device selected from one or more of the group consisting of: a chip [86], an RFID device [88], and a solid state device [85]. According to some embodiments, the gift card [19] may be configured to support added digital promotions, coupons, funds, or credits from various non-affiliated vendors or entities [65].

A browser [131] is further disclosed. According to some embodiments, the browser [131] may be configured for communicating with a profile [130] of a user [91]; for example, a user [91] accessing the browser [131]. According to some embodiments, the browser [131] may comprise a plurality of displayed redemption options available for purchase by the user [91]. According to some embodiments, the browser [131] may comprise indicia provided adjacent at least one of the plurality of displayed redemption options. According to some embodiments, the indicia may be associated with the profile [130]. According to some embodiments, the indicia may comprise an active link. According to some embodiments, the active link may be configured to be interacted with by pressing, touching, hovering a cursor over, dragging, operatively engaging, tactilely engaging, right-clicking, left-clicking, clicking, or holding the indicia. According to some embodiments, the browser [131] may comprise means for sending the at least one of the plurality of displayed redemption options to a contact, relative, or friend [145] associated with the profile [130]. According to some embodiments, the means for sending the at least one of the plurality of displayed redemption options to a contact, relative, or friend [145] associated with the profile [130] may comprise a prompt; wherein the prompt may provide an option to the user [91] of the browser [131] to send the at least one of the plurality of displayed redemption options to a contact, relative, or friend [145] associated with the profile [130]. According to some embodiments, the prompt may comprise alphanumeric indicia suggesting “Send to a Friend” or “Send to a Friend?” in a predetermined language. According to some embodiments, the indicia may be scrollable. According to some embodiments, the indicia may comprise an avatar image. According to some embodiments, the indicia may comprise an avatar image of one or more contacts, relatives, or friends [145] associated with the profile [130]. According to some embodiments, the indicia may comprise user data [8]. According to some embodiments, the user data [8] may comprise a name [47]. According to some embodiments, when the active link is interacted with by a user [91], a pop-up may be displayed; for example, a pop-up window, a pop-up web page, a pop-up box, a pop-up bubble, or the like. According to some embodiments, the pop-up may comprise a scroll bar. According to some embodiments, contacts, relatives, or friends [145] associated with the profile [130]; for example, contacts, relatives, or friends [145] associated with the profile [130] which have a greater amount of recent activity with the profile [130], may be displayed more prominently or otherwise more conspicuously than contacts, relatives, or friends [145] associated with the profile [130] which have a lesser amount of recent activity with the profile [130].

A method of communicating information regarding a purchasable good, service, or redemption option [151] which is configured to facilitate an update or change to information relating to a profile [130] of a viewer [91] is disclosed. According to some embodiments, the method may comprise the step of providing, via a media visual broadcast, at least one instruction to a viewer, wherein the at least one instruction to a viewer [91] may comprise at least one of audio data [7] and image data [6]. According to some embodiments, the at least one instruction may comprise an option for the viewer [91] to perform a function. According to some embodiments, the function, when completed, may result in the update or change to information relating to a profile [130] of the viewer [91]. According to some embodiments, the update or change to information relating to a profile [130] of a viewer [91] may comprise one or more of the group consisting of: a change in a profile [130] status of the viewer [91]; a change in a profile [130] feed of the viewer [91]; a change in a profile [130] shopping list of the viewer [91]; a change in a profile [130] gift list of the viewer [91]; a change in a profile [130] registry of the viewer [91]; a change in a profile [130] wish list of the viewer [91]; a change in a profile [130] favorable opinion of the viewer [91]; a change in a profile [130] favorite of the viewer [91]; a change in a profile [130] shopping list of a contact, relative, or friend of the viewer [91]; a change in a profile [130] feed of a contact, relative, or friend of the viewer [91]; a change in a profile [130] shopping list of a contact, relative, or friend of the viewer [91]; a change in a profile [130] gift list of a contact, relative, or friend of the viewer [91]; a change in a profile [130] registry of a contact, relative, or friend of the viewer [91]; a change in a profile [130] wish list of a contact, relative, or friend of the viewer [91]; a change in a profile [130] favorable opinion of a contact, relative, or friend of the viewer [91]; and a change in a profile [130] favorite of a contact, relative, or friend of the viewer [91]. According to some embodiments, the update or change to information relating to a profile [130] of a viewer [91] may comprise a change in funds or credits associated with the viewer [91]. According to some embodiments, the change in funds or credits associated with the viewer [91] may comprise a change in payment data [10]. According to some embodiments, the change in payment data [10] of the viewer may comprise a change or update to at least one of the group consisting of: an account [48] balance, funds or credits associated with an account [17] or account ledger, digital wallet information, a cash or currency [11] balance or ledger, a credit card [12] balance, a debit card balance, an electronic benefits transfer (EBT) card [13] balance, a check [14] credit balance, a gift card [15] credit balance, an account balance associated with a gift card [15], a voucher credit balance, an account balance associated with a voucher, a vendor/entity [65] account balance, a gift certificate balance, a rewards/loyalty points balance, a frequent flyer miles balance, funds or credits associated with a coupon [16] or coupon code [16]; digital/electronic currency funds, a loan value, and funds or assets associated with a stock, fund, or tradable asset [81]. According to some embodiments, the instruction to a viewer [91] may comprise image data [6]. According to some embodiments, the image data [6] may comprise first indicia having the word “text” in a predetermined language adjacent a first number. According to some embodiments, the image data [6] may comprise second indicia including an alpha-numeric string. According to some embodiments, the second indicia may comprise identifying information adjacent the alpha-numeric string. According to some embodiments, the identifying information may include at least one or more of the words, phrases, or characters selected from the group consisting of: “friend”, “friends”, a trademark, word or phrase indicative of a social platform, “buddy”, “account”, “follow”, “hashtag”, “social”, “post”, “add”, “like”, “your”, “profile”, “shopping”, “shopping list”, “wish”, “list”, “gift”, “send”, “buy for”, “update”, “purchase”, “buy”, “feed”, “timeline”, “recommend”, “promote”, “pay”, “pay for”, “favorite”, “favorites”, “poke”, “peek, “registry”, “us”, “find”, “review”, “connect”, “share”, “give”, “donate”, “credit”, “funds”, “+”, “+1”, “1”, “in”, “#”, “@”, “>”, “−”, “→”, “ [symbol] ”, and “:)”. According to some embodiments, the identifying information may include one or more icons associated with a connotation or meaning, the connotation or meaning being selected from one or more of the group consisting of: a favorable opinion, a negative opinion, a like, a favorite, a wish, an ability to share, an ability to send, an ability to add, an ability to update, an ability to purchase, an ability to donate, an ability to post, an ability to like, an ability to review, an ability to receive discounts, an ability to adjust a profile, an ability to adjust account information, an ability to add to a personal list, an ability to add to a list associated with a contact, relative, or friend, an ability to add to a personal registry, and an ability to add to a registry of a contact, friend, or relative. According to some non-limiting embodiments, the one or more icons may be selected from one or more of the group consisting of: a thumbs-up icon, a thumbs-down item, a fingers crossed icon, an icon comprising a string around a finger, an icon in the shape of a star, an icon comprising one or more arrows, an icon resembling a present or package, an icon resembling an envelope, an icon resembling a mobile device, an icon resembling a computer, an icon comprising a “−”, an icon comprising the word “like”, an icon suggesting the act of liking, an icon suggesting a positive or favorable opinion, an icon suggesting a positive review, an icon comprising the word “dislike”, an icon suggesting the act of disliking, an icon suggesting a negative or unfavorable opinion, an icon suggesting a negative review, an icon comprising an alphanumeric or Greek character, an icon comprising the word “friend”, an icon comprising the word “friends”, an icon suggesting a social media network, an icon suggesting a social media website, an icon suggesting the act of sharing, an icon suggesting the act of being social, an icon suggesting the act of connecting, an icon suggesting the act of posting, an icon suggesting the act of adding, an icon suggesting the act of liking, an icon suggesting personal ownership of something, an icon suggesting a profile, an icon suggesting a social network profile, an icon suggesting a system profile, an icon in the form of a shopping cart, an icon suggesting the act of shopping, an icon in the shape of an envelope, an icon suggesting a shopping list, an icon suggesting the act of wishing, an icon suggesting the act of listing, an icon suggesting the act of giving, an icon suggesting the act of gifting, an icon suggesting the act of sending, an icon suggesting the act of updating, an icon suggesting the act of messaging, an icon suggesting the act of buying, an icon suggesting the act of paying, an icon suggesting the act of favoring, an icon suggesting the act of adding as a favorite, an icon suggesting the act of reviewing, an icon suggesting the act of “connecting”, an icon suggesting the act of “sharing”, an icon suggesting the act of giving, an icon suggesting the act of donating, an icon suggesting the act of crediting, an icon suggesting the act of sending or using funds or credits, an icon containing the character “+”, an icon comprising the number “1”, an icon comprising bird indicia, an icon comprising a combination of alphanumeric characters, an icon comprising a fanciful letter, and a smiley face icon. According to some embodiments, the one or more icons may represent or otherwise have, possess, or denote a connotation, meaning, affiliation, or association with one or more redemption options. According to some embodiments, the one or more redemption options may be selected from one or more of the group consisting of: a good, a service, an offer, a promotion, a deal, a coupon, a credit, a fund, and a type [72] of redemption option. According to some embodiments, the one or more icons may represent or otherwise have a connotation, meaning, affiliation, or association with brand of good or service [151], a brand of a vendor or entity [65], or a particular venue or location [2]. According to some embodiments, the method may comprise the viewer [91] texting the alpha-numeric string to the first number using a mobile device [96], wherein thereafter, an update or change to information relating to a profile [130] of the viewer [91] may be made. According to some embodiments, the method may comprise providing a plurality of alpha-numeric strings to the viewer, and a plurality of identifying information adjacent to each of the plurality of alpha-numeric strings. According to some embodiments, each of the plurality of identifying information may be different. According to some embodiments, each of the alpha-numeric strings may be different. According to some embodiments, the method may comprise the viewer [91] selecting one of the plurality of identifying information. According to some embodiments, the method may comprise texting the respective alpha-numeric string adjacent the selected one of the plurality of identifying information to the first number using a mobile device [96], wherein thereafter, an update or change to information relating to a profile [130] of the viewer [91] may be made. According to some embodiments, the plurality of identifying information adjacent to each of the plurality of alpha-numeric strings may be associated with one or more of the functions selected from the group consisting of: posting via the profile [130]; posting to the profile [130]; posting to a contact, relative, or friend associated with the profile [130]; posting to a second profile [130] which is associated with the profile [130]; adding favorable opinion information to the profile; adding favorable opinion information to a second profile [130] associated with the profile [130]; sending funds or credits via the profile [130]; deducting funds or credits via the profile [130]; sending audio data [7] to the viewer [91]; sending image data [6] to the viewer [91]; sending audio data [7] to a contact, relative, or friend of the viewer [91]; sending image data [6] to a contact, relative, or friend of the viewer [91]; sending information to a contact, relative, or friend of the viewer [91] pertaining to a redemption option; sending funds or credits to an individual affiliated with the profile [130]; ordering a redemption option for a person associated with the profile [130]; adding to a personal shopping list associated with the profile [130] of the viewer [91]; adding to a shopping list associated with an another individual associated with the profile [130]; adding to a gifting list associated with the profile [130] of the viewer [91]; adding to a gifting list associated with a contact, friend, or relative associated with the viewer [91] and/or profile [130] of the viewer [91]; adding to a personal wish list associated with the profile [130] of the viewer [91]; and adding to a wish list associated with an another individual associated with the profile [130]. According to some embodiments, the profile [130] may be at least one of: a system profile, a social network [93] profile, a vendor or selling entity [65] profile. According to some embodiments, the step of providing, via a media visual broadcast, at least instruction to a viewer may be performed via one of the group consisting of: a TV network, a media affiliate, a syndicated broadcast, a local TV network, an in-home shopping network, an advertising-supported channel, a television program, a streaming media provider, a streaming media website, a vendor or selling entity [65], a venue [2], a CCTV broadcast, an internet media stream, a cable service provider, an internet service provider, a TV commercial, recorded media, a DVD, a CD, media on a hard drive, media configured to be delivered to a TV, media configured to be delivered to a display monitor, visual media, media delivered via a system application, a browser [131], and a system application [147].

A method of communicating information regarding a purchasable good, service, or redemption option [151] is disclosed. According to some embodiments, the method may comprise a system configured to facilitate an update or change to information relating to a profile [130] of a potential user [91] of an article. According to some embodiments, the method may comprise providing an article; for example, an article which may comprise at least one instruction to a potential user [91] of the article. According to some embodiments, the at least one instruction to a potential user [91] may comprise at least one of audio data [7] and image data [6]. According to some embodiments, the at least one instruction may comprise an option for the potential user [91] to perform a function, the function, when completed, resulting in the update or change to information relating to a profile [130] of the potential user [91]. According to some embodiments, the update or change to information relating to a profile [130] of a user [91] may comprise one or more of the group consisting of: a change in a profile [130] status of the user [91]; a change in a profile [130] feed of the user [91]; a change in a profile [130] shopping list of the user [91]; a change in a profile [130] gift list of the user [91]; a change in a profile [130] registry of the user [91]; a change in a profile [130] wish list of the user [91]; a change in a profile [130] favorable opinion of the user [91]; a change in a profile [130] favorite of the user [91]; a change in a profile [130] shopping list of a contact, relative, or friend of the user [91]; a change in a profile [130] feed of a contact, relative, or friend of the user [91]; a change in a profile [130] shopping list of a contact, relative, or friend of the user [91]; a change in a profile [130] gift list of a contact, relative, or friend of the user [91]; a change in a profile [130] registry of a contact, relative, or friend of the user [91]; a change in a profile [130] wish list of a contact, relative, or friend of the user [91]; a change in a profile [130] favorable opinion of a contact, relative, or friend of the user [91]; and a change in a profile [130] favorite of a contact, relative, or friend of the user [91].

According to some embodiments, the update or change to information relating to a profile [130] of a user [91] may comprise a change in funds or credits associated with the user [91]. According to some embodiments, the change in funds or credits associated with the user [91] may comprise a change in payment data [10]. According to some embodiments, the change in payment data [10] of the user may comprise a change or update to at least one of the group consisting of: an account [48] balance; funds or credits associated with an account [17] or account ledger; digital wallet information; a cash or currency [11] balance or ledger; a credit card [12] balance; a debit card balance; an electronic benefits transfer (EBT) card [13] balance; a check [14] credit balance; a gift card [15] credit balance; an account balance associated with a gift card [15]; a voucher credit balance; an account balance associated with a voucher; a vendor/entity [65] account balance; a gift certificate balance; a rewards/loyalty points balance; a frequent flyer miles balance; funds or credits associated with a coupon [16] or coupon code [16]; digital/electronic currency funds; a loan value; and funds or assets associated with a stock, fund, or tradable asset [81]. According to some embodiments, the instruction to a user [91] may comprise image data [6], wherein the image data [6] may comprise first indicia having the word “text” in a predetermined language adjacent a first number. According to some embodiments, the image data [6] may comprise second indicia including an alpha-numeric string. According to some embodiments, the second indicia may comprise identifying information adjacent the alpha-numeric string. According to some non-limiting embodiments, the one or more icons may be selected from one or more of the group consisting of: a thumbs-up icon, a thumbs-down item, a fingers crossed icon, an icon comprising a string around a finger, an icon in the shape of a star, an icon comprising one or more arrows, an icon resembling a present or package, an icon resembling an envelope, an icon resembling a mobile device, an icon resembling a computer, an icon comprising a “−”, an icon comprising the word “like”, an icon suggesting the act of liking, an icon suggesting a positive or favorable opinion, an icon suggesting a positive review, an icon comprising the word “dislike”, an icon suggesting the act of disliking, an icon suggesting a negative or unfavorable opinion, an icon suggesting a negative review, an icon comprising an alphanumeric or Greek character, an icon comprising the word “friend”, an icon comprising the word “friends”, an icon suggesting a social media network, an icon suggesting a social media website, an icon suggesting the act of sharing, an icon suggesting the act of being social, an icon suggesting the act of connecting, an icon suggesting the act of posting, an icon suggesting the act of adding, an icon suggesting the act of liking, an icon suggesting personal ownership of something, an icon suggesting a profile, an icon suggesting a social network profile, an icon suggesting a system profile, an icon in the form of a shopping cart, an icon suggesting the act of shopping, an icon in the shape of an envelope, an icon suggesting a shopping list, an icon suggesting the act of wishing, an icon suggesting the act of listing, an icon suggesting the act of giving, an icon suggesting the act of gifting, an icon suggesting the act of sending, an icon suggesting the act of updating, an icon suggesting the act of messaging, an icon suggesting the act of buying, an icon suggesting the act of paying, an icon suggesting the act of favoring, an icon suggesting the act of adding as a favorite, an icon suggesting the act of reviewing, an icon suggesting the act of “connecting”, an icon suggesting the act of “sharing”, an icon suggesting the act of giving, an icon suggesting the act of donating, an icon suggesting the act of crediting, an icon suggesting the act of sending or using funds or credits, an icon containing the character “+”, an icon comprising the number “1”, an icon comprising bird indicia, an icon comprising a combination of alphanumeric characters, an icon comprising a fanciful letter, and a smiley face icon. According to some embodiments, the one or more icons may represent or otherwise have, possess, or denote a connotation, meaning, affiliation, or association with one or more redemption options. According to some embodiments, the one or more redemption options may be selected from one or more of the group consisting of: a good, a service, an offer, a promotion, a deal, a coupon, a credit, a fund, and a type [72] of redemption option. According to some embodiments, the one or more icons may represent or otherwise have a connotation, meaning, affiliation, or association with brand of good or service [151], a brand of a vendor or entity [65], or a particular venue or location [2]. According to some embodiments, the method may comprise the user [91] texting the alpha-numeric string to the first number using a mobile device [96], wherein thereafter, an update or change to information relating to a profile [130] of the user [91] may be made. According to some embodiments, the method may comprise providing a plurality of alpha-numeric strings to the user [91], and a plurality of identifying information adjacent to each of the plurality of alpha-numeric strings. According to some embodiments, each of the plurality of identifying information may be different. According to some embodiments, each of the alpha-numeric strings may be different. According to some embodiments, the method may comprise the user [91] selecting one of the plurality of identifying information. According to some embodiments, the method may comprise texting the respective alpha-numeric string adjacent the selected one of the plurality of identifying information to the first number using a mobile device [96], wherein thereafter, an update or change to information relating to a profile [130] of the user [91] may be made.

According to some embodiments, the plurality of identifying information adjacent to each of the plurality of alpha-numeric strings may be associated with one or more functions selected from the group consisting of: posting via the profile [130], posting to the profile [130], posting to a contact, relative, or friend associated with the profile [130], posting to a second profile [130] which is associated with the profile [130], adding favorable opinion information to the profile, adding favorable opinion information to a second profile [130] associated with the profile [130], sending funds or credits via the profile [130], deducting funds or credits via the profile [130], sending audio data [7] to the user [91], sending image data [6] to the user [91], sending audio data [7] to a contact, relative, or friend of the user [91], sending image data [6] to a contact, relative, or friend of the user [91], sending information to a contact, relative, or friend of the user [91] pertaining to a redemption option, sending funds or credits to an individual affiliated with the profile [130], ordering a redemption option for a person associated with the profile [130], adding to a personal shopping list associated with the profile [130] of the user [91], adding to a shopping list associated with an another individual associated with the profile [130]; adding to a gifting list associated with the profile [130] of the user [91]; adding to a gifting list associated with a contact, friend, or relative associated with the user [91] and/or profile [130] of the user [91]; adding to a personal wish list associated with the profile [130] of the user [91], and adding to a wish list associated with an another individual associated with the profile [130]. According to some embodiments, the profile [130] may be at least one of: a system profile, a social network [93] profile, a vendor or selling entity [65] profile. According to some embodiments, the step of providing an article may comprise at least one instruction to a potential user [91] of the article may be performed via one of the group consisting of: a manufacturer of the article, a distributer of the article, and a vendor or entity [65] providing the article. According to some embodiments, the article may be selected from one or more of the group consisting of: an electronic device, a paper-based article, a receipt [20], a card [19], a software application [147], a disposable article, a tag, a display, a sign, a poster, an advertisement, a billboard, a mobile device [96], a food container, a container of a purchasable good or service [151], a purchasable good [151], a purchasable service [151], a redemption option [151], a browser [131], a system website [127], a third-party website [127] browser [131], and a kiosk [3] display means [109]. According to some embodiments, the instruction to a user [91] may comprise image data [6], wherein the image data [6] may comprise first indicia having a code thereon. According to some embodiments, the code may comprise a 1D barcode, a 2D barcode, a data matrix code, or a QR code. According to some embodiments, the code may be readable using a mobile device [96]. According to some embodiments, the code may be integrated with a system-based or third party application [147]. According to some embodiments, when the code is read by the mobile device [96], the system-based or third-party application [147] may execute the step of updating or changing information relating to the profile [130] of the user [91] who reads the code using the mobile device [96]. According to some embodiments, the code may contain one or more of the group consisting of: redemption data [64], and vendor or selling entity [64] data. According to some embodiments, when scanned by a user's [91] mobile device [64], user data [8] and/or information relating to the user's [91] profile [130], such as the user's phone number [53] or email address [47], may be sent to a database [122, 129, 135, 137].

A method of communicating information regarding a purchasable good, service, or redemption option [151] is further disclosed. According to some embodiments, a system associated with the method may be configured to facilitate an update or change to information relating to a profile [130] of a listener [91]. According to some embodiments, the method may comprise the step of providing, via an audio broadcast, at least one instruction to a listener [91]. According to some embodiments, the at least one instruction to a listener [91] may comprise audio data [7]. According to some embodiments, the at least one instruction may comprise an option for the listener [91] to perform a function. According to some embodiments, the function, when completed, may result in the update or change to information relating to a profile [130] of the listener [91]. According to some embodiments, the function may be performed via a listener's mobile device [96] or vehicle hands-off voice command system equipped with audio input means [103] and communication capabilities equivalent to that of a network [118]-connected mobile device [96]. According to some embodiments, the function may incorporate the use of SMS, MMS, alpha-numeric message-based texts, or mobile device-based texting protocols, for the purpose of updating or changing information associated with a profile [130] of the listener. According to some embodiments, the update or change to information relating to a profile [130] of a listener [91] may comprise one or more of the group consisting of: a change in a profile [130] status of the listener [91]; a change in a profile [130] feed of the listener [91]; a change in a profile [130] shopping list of the listener [91]; a change in a profile [130] gift list of the listener [91]; a change in a profile [130] registry of the listener [91]; a change in a profile [130] wish list of the listener [91]; a change in a profile [130] favorable opinion of the listener [91]; a change in a profile [130] favorite of the listener [91]; a change in a profile [130] shopping list of a contact, relative, or friend of the listener [91]; a change in a profile [130] feed of a contact, relative, or friend of the listener [91]; a change in a profile [130] shopping list of a contact, relative, or friend of the listener [91]; a change in a profile [130] gift list of a contact, relative, or friend of the listener [91]; a change in a profile [130] registry of a contact, relative, or friend of the listener [91]; a change in a profile [130] wish list of a contact, relative, or friend of the listener [91]; a change in a profile [130] favorable opinion of a contact, relative, or friend of the listener [91]; and a change in a profile [130] favorite of a contact, relative, or friend of the listener [91]. According to some embodiments, the update or change to information relating to a profile [130] of a listener [91] may comprise a change in funds or credits associated with the listener [91]. According to some embodiments, the change in funds or credits associated with the listener [91] may comprise a change in payment data [10]. According to some embodiments, the change in payment data [10] of the listener may comprise a change or update to at least one of the group consisting of: an account [48] balance; funds or credits associated with an account [17] or account ledger; digital wallet information; a cash or currency [11] balance or ledger; a credit card [12] balance; a debit card balance; an electronic benefits transfer (EBT) card [13] balance; a check [14] credit balance; a gift card [15] credit balance; an account balance associated with a gift card [15]; a voucher credit balance; an account balance associated with a voucher; a vendor/entity [65] account balance; a gift certificate balance; a rewards/loyalty points balance; a frequent flyer miles balance; funds or credits associated with a coupon [16] or coupon code [16]; digital/electronic currency funds; a loan value; and funds or assets associated with a stock, fund, or tradable asset [81]. According to some embodiments, the instruction to a listener [91] may comprise audio data [7]; wherein the audio data [7] may comprise the spoken word “text” in a predetermined language. According to some embodiments, the audio data [7] may comprise a spoken alphanumeric string. According to some embodiments, the method may comprise delivering identifying information with the alpha-numeric string to the listener [91]. According to some embodiments, the identifying information may include one or more of the spoken words, spoken phrases, or spoken characters selected from the group consisting of: “friend”, “friends”, a trademark, word or phrase indicative of a social platform, “buddy”, “account”, “follow”, “hashtag”, “social”, “post”, “add”, “like”, “your”, “profile”, “shopping”, “shopping list”, “wish”, “list”, “gift”, “send”, “buy for”, “update”, “purchase”, “buy”, “feed”, “timeline”, “recommend”, “promote”, “pay”, “pay for”, “favorite”, “favorites”, “poke”, “peek, “registry”, “us”, “find”, “review”, “connect”, “share”, “give”, “donate”, “credit”, “funds”, “plus”, “in”, “pound sign”, “hash”, “at”, and “smiley face”. According to some embodiments, the identifying information may include one or more informative phrases associated with a connotation or meaning, the connotation or meaning being selected from one or more of the group consisting of: a favorable opinion, a negative opinion, a like, a favorite, a wish, an ability to share, an ability to send, an ability to add, an ability to update, an ability to purchase, an ability to donate, an ability to post, an ability to like, an ability to review, an ability to receive discounts, an ability to adjust a profile, an ability to adjust account information, an ability to add to a personal list, an ability to add to a list associated with a contact, relative, or friend, an ability to add to a personal registry, and an ability to add to a registry of a contact, friend, or relative. According to some embodiments, the identifying information may be configured to convey steps relating to utilizing SMS, MMS, alpha-numeric message-based texts, or mobile device-based texting protocols, for the purpose of updating or changing information associated with a profile [130] of the listener. According to some embodiments, the steps may be selected from one or more of the group consisting of: giving a thumbs-up, giving a thumbs-down, crossing fingers, sending a present or package, sending via a mobile device, sending a “like” via text, updating profile [130] information via text or texting protocols, suggesting the act of liking, suggesting giving a positive or favorable opinion, suggesting a positive review, suggesting a “dislike”, suggesting the act of disliking, suggesting a negative or unfavorable opinion, suggesting a negative review, using the word “friend”, using the word “friends”, suggesting a social media network, suggesting a social media website, suggesting social media network functions, suggesting third party website functions, suggesting system functions, suggesting the act of sharing, suggesting the act of being social, suggesting the act of connecting, suggesting the act of posting, suggesting the act of adding, suggesting the act of liking, suggesting personal ownership of something, suggesting a profile, suggesting a social network profile, suggesting a system profile, suggesting a shopping cart, suggesting the act of shopping, suggesting the act of sending, suggesting the act of updating a profile shopping list, suggesting the act of wishing, suggesting the act of listing, suggesting the act of giving, suggesting the act of gifting, suggesting the act of sending, suggesting the act of updating, suggesting the act of messaging, suggesting the act of buying, suggesting the act of paying, suggesting the act of favoring, suggesting the act of adding as a favorite, suggesting the act of reviewing, suggesting the act of posting to a social network, suggesting the act of “following”, suggesting the act of “connecting”, suggesting the act of “sharing”, suggesting the act of giving, suggesting the act of donating, suggesting the act of crediting, suggesting the act of sending or using funds or credits, suggesting giving a “+” (plus), suggesting giving a “−” (minus), suggesting giving a “+1”, suggesting the act of blogging or micro-blogging, and suggesting the act of smiling. According to some embodiments, the identifying information may represent or otherwise have a connotation, meaning, affiliation, or association with one or more redemption options. According to some embodiments, the one or more redemption options may be selected from one or more of the group consisting of: a good, a service, an offer, a promotion, a deal, a coupon, a credit, a fund, and a type [72] of redemption option. According to some embodiments, the identifying information may represent or otherwise has a connotation, meaning, affiliation, or association with brand of good or service [151], a brand of a vendor or entity [65], or a particular venue or location [2]. According to some embodiments, the method may comprise the listener [91] texting the alpha-numeric string to the first number using a mobile device [96] or vehicle hands-off voice command system, wherein thereafter, an update or change to information relating to a profile [130] of the listener [91] may be made. According to some embodiments, the method may comprise verbally providing a plurality of alphanumeric strings to the listener [91], and a plurality of identifying information within a close proximity of time for each of the verbally provided plurality of alpha-numeric strings, wherein each of the plurality of identifying information may be different, and/or wherein each of the alphanumeric strings may be different. According to some embodiments, the method may comprise the listener [91] selecting one of the plurality of identifying information, and texting the respective alpha-numeric string corresponding to the selected one of the plurality of identifying information to the first number using the mobile device [96] or vehicle hands-off voice command system, wherein thereafter, an update or change to information relating to a profile [130] of the listener [91] may be made. According to some embodiments, the plurality of identifying information within a close proximity of time for each of the plurality of alpha-numeric strings may be associated with one or more functions selected from the group consisting of: posting via the profile [130], posting to the profile [130], posting to a contact, relative, or friend associated with the profile [130], posting to a second profile [130] which may be associated with the profile [130], adding favorable opinion information to the profile, adding favorable opinion information to a second profile [130] associated with the profile [130], sending funds or credits via the profile [130], deducting funds or credits via the profile [130], sending audio data [7] to the listener [91], sending image data [6] to the listener [91], sending audio data [7] to a contact, relative, or friend of the listener [91], sending image data [6] to a contact, relative, or friend of the listener [91], sending information to a contact, relative, or friend of the listener [91] pertaining to a redemption option, sending funds or credits to an individual affiliated with the profile [130], ordering a redemption option for a person associated with the profile [130], adding to a personal shopping list associated with the profile [130] of the listener [91], adding to a shopping list associated with an another individual associated with the profile [130]; adding to a gifting list associated with the profile [130] of the listener [91]; adding to a gifting list associated with a contact, friend, or relative associated with the listener [91] and/or profile [130] of the listener [91]; adding to a personal wish list associated with the profile [130] of the listener [91], and adding to a wish list associated with an another individual associated with the profile [130]. According to some embodiments, the profile [130] may be at least one of: a system profile, a social network [93] profile, a vendor or selling entity [65] profile. According to some embodiments, the step of providing, via a media audio broadcast, at least instruction to a listener may be performed via one of the group consisting of: a TV network, a syndicated television broadcast, a local TV network, an in-home shopping network, an advertising-supported TV channel, a television program, a radio network, a media affiliate, a syndicated audio broadcast, a local radio station, a satellite radio service provider, a radio-based shopping network, an advertising-supported radio station, a radio program, a streaming media provider, a streaming media website [127], a vendor or selling entity [65], a venue [2], a CCTV broadcast, an internet media stream, a cable service provider, an internet service provider, a TV commercial, recorded media, a DVD, a CD, media on a hard drive, media configured to be delivered to a TV, media configured to be delivered via AM/FM radio, media configured to be delivered to a sound-emitting device, audio media, media delivered via a system application (e.g., iTunes), a browser [131], a website (for example, a system website or a third-party website), a third-party system application [148], and a system application [147].

An article comprising a purchasable good, service, or redemption option [151] is disclosed. According to some embodiments, the article may comprise indicia thereon, wherein the indicia may be configured to allow a user [91] of the article to update or change to information relating to a profile [130] of the user [91] of the article. According to some embodiments, the article may comprise: at least one instruction intended for a user [91] of the article, wherein the at least one instruction may comprise at least one of audio data [7] and image data [6]; wherein the at least one instruction may comprise an option for the user [91] to perform a function, wherein according to some embodiments, the function, when completed, may result in the update or change to information relating to a profile [130] of the user [91]; wherein the function may be performed via the user's mobile device [96] or vehicle hands-off voice command system equipped with audio input means [103] and communication capabilities equivalent to that of a network [118]-connected mobile device [96]. According to some embodiments, the function may incorporate the use of SMS, MMS, alpha-numeric message-based texts, or mobile device-based texting protocols, for the purpose of updating or changing information associated with a profile [130] of the user [91]. According to some embodiments, the update or change to information relating to a profile [130] of the user [91] may comprise one or more of the group consisting of: a change in a profile [130] status of the user [91]; a change in a profile [130] feed of the user [91]; a change in a profile [130] shopping list of the user [91]; a change in a profile [130] gift list of the user [91]; a change in a profile [130] registry of the user [91]; a change in a profile [130] wish list of the user [91]; a change in a profile [130] favorable opinion of the user [91]; a change in a profile [130] favorite of the user [91]; a change in a profile [130] shopping list of a contact, relative, or friend of the user [91]; a change in a profile [130] feed of a contact, relative, or friend of the user [91]; a change in a profile [130] shopping list of a contact, relative, or friend of the user [91]; a change in a profile [130] gift list of a contact, relative, or friend of the user [91]; a change in a profile [130] registry of a contact, relative, or friend of the user [91]; a change in a profile [130] wish list of a contact, relative, or friend of the user [91]; a change in a profile [130] favorable opinion of a contact, relative, or friend of the user [91]; and a change in a profile [130] favorite of a contact, relative, or friend of the user [91]. According to some embodiments, the update or change to information relating to a profile [130] of a user [91] may comprise a change in funds or credits associated with the user [91]. According to some embodiments, the change in funds or credits associated with the user [91] may comprise a change in payment data [10]. According to some embodiments, the change in payment data [10] of the user may comprise a change or update to at least one of the group consisting of: an account [48] balance; funds or credits associated with an account [17] or account ledger; digital wallet information; a cash or currency [11] balance or ledger; a credit card [12] balance; a debit card balance; an electronic benefits transfer (EBT) card [13] balance; a check [14] credit balance; a gift card [15] credit balance; an account balance associated with a gift card [15]; a voucher credit balance; an account balance associated with a voucher; a vendor/entity [65] account balance; a gift certificate balance; a rewards/loyalty points balance; a frequent flyer miles balance; funds or credits associated with a coupon [16] or coupon code [16]; digital/electronic currency funds; a loan value; and funds or assets associated with a stock, fund, or tradable asset [81]. According to some embodiments, the instruction to a user [91] may comprise image data [6], wherein the image data [6] may comprise first indicia having the word “text” in a predetermined language adjacent a first number. According to some embodiments, the image data [6] may comprise second indicia including an alpha-numeric string. According to some embodiments, the second indicia may comprise identifying information adjacent the alpha-numeric string. According to some embodiments, the identifying information may include at least one or more of the words, phrases, or characters selected from the group consisting of: “friend”, “friends”, a trademark, word or phrase indicative of a social platform, “buddy”, “account”, “follow”, “hashtag”, “social”, “post”, “add”, “like”, “your”, “profile”, “shopping”, “shopping list”, “wish”, “list”, “gift”, “send”, “buy for”, “update”, “purchase”, “buy”, “feed”, “timeline”, “recommend”, “promote”, “pay”, “pay for”, “favorite”, “favorites”, “poke”, “peek, “registry”, “us”, “find”, “review”, “connect”, “share”, “give”, “donate”, “credit”, “funds”, “+”, “+1”, “1”, “in”, “#”, “@”, “>”, “−”, “→”, “ [symbol] ”, and “:)”. According to some embodiments, the identifying information may include one or more icons associated with a connotation or meaning, wherein the connotation or meaning may be selected from one or more of the group consisting of: a favorable opinion, a negative opinion, a like, a favorite, a wish, an ability to share, an ability to send, an ability to add, an ability to update, an ability to purchase, an ability to donate, an ability to post, an ability to like, an ability to review, an ability to receive discounts, an ability to adjust a profile, an ability to adjust account information, an ability to add to a personal list, an ability to add to a list associated with a contact, relative, or friend, an ability to add to a personal registry, and an ability to add to a registry of a contact, friend, or relative.

According to some embodiments, the one or more icons may be selected from one or more of the group consisting of: a thumbs-up icon, a thumbs-down item, a fingers crossed icon, an icon comprising a string around a finger, an icon in the shape of a star, an icon comprising one or more arrows, an icon resembling a present or package, an icon resembling an envelope, an icon resembling a mobile device, an icon resembling a computer, an icon comprising a “−”, an icon comprising the word “like”, an icon suggesting the act of liking, an icon suggesting a positive or favorable opinion, an icon suggesting a positive review, an icon comprising the word “dislike”, an icon suggesting the act of disliking, an icon suggesting a negative or unfavorable opinion, an icon suggesting a negative review, an icon comprising an alphanumeric or Greek character, an icon comprising the word “friend”, an icon comprising the word “friends”, an icon suggesting a social media network, an icon suggesting a social media website, an icon suggesting the act of sharing, an icon suggesting the act of being social, an icon suggesting the act of connecting, an icon suggesting the act of posting, an icon suggesting the act of adding, an icon suggesting the act of liking, an icon suggesting personal ownership of something, an icon suggesting a profile, an icon suggesting a social network profile, an icon suggesting a system profile, an icon in the form of a shopping cart, an icon suggesting the act of shopping, an icon in the shape of an envelope, an icon suggesting a shopping list, an icon suggesting the act of wishing, an icon suggesting the act of listing, an icon suggesting the act of giving, an icon suggesting the act of gifting, an icon suggesting the act of sending, an icon suggesting the act of updating, an icon suggesting the act of messaging, an icon suggesting the act of buying, an icon suggesting the act of paying, an icon suggesting the act of favoring, an icon suggesting the act of adding as a favorite, an icon suggesting the act of reviewing, an icon suggesting the act of “connecting”, an icon suggesting the act of “sharing”, an icon suggesting the act of giving, an icon suggesting the act of donating, an icon suggesting the act of crediting, an icon suggesting the act of sending or using funds or credits, an icon containing the character “+”, an icon comprising the number “1”, an icon comprising bird indicia, an icon comprising a combination of alphanumeric characters, an icon comprising a fanciful letter, and a smiley face icon. According to some embodiments, the one or more icons may represent or otherwise have a connotation, meaning, affiliation, or association with one or more redemption options. According to some embodiments, the one or more redemption options may be selected from one or more of the group consisting of: a good, a service, an offer, a promotion, a deal, a coupon, a credit, a fund, and a type [72] of redemption option. According to some embodiments, the one or more icons may represent or otherwise have a connotation, meaning, affiliation, or association with brand of good or service [151], a brand of a vendor or entity [65], or a particular venue or location [2]. According to some embodiments, the user [91] may text the alpha-numeric string to the first number using a mobile device [96] or vehicle hands-off voice command system, wherein thereafter, an update or change to information relating to a profile [130] of the user [91] may be made. According to some embodiments, the article may comprise a plurality of alpha-numeric strings for user [91] interpretation, and a plurality of identifying information adjacent to each of the plurality of alpha-numeric strings, wherein each of the plurality of identifying information may be different, and wherein each of the alpha-numeric strings may be different. According to some embodiments, the user [91] may select one of the plurality of identifying information, and may text the respective alpha-numeric string adjacent the selected one of the plurality of identifying information to the first number using a mobile device [96] or vehicle hands-off voice command system, wherein thereafter, an update or change to information relating to a profile [130] of the user [91] may be made. According to some embodiments, the plurality of identifying information adjacent to each of the plurality of alpha-numeric strings may be associated with one or more functions selected from one or more of the group consisting of: posting via the profile [130]; posting to the profile [130]; posting to a contact, relative, or friend associated with the profile [130]; posting to a second profile [130] which may be associated with the profile [130]; adding favorable opinion information to the profile; adding favorable opinion information to a second profile [130] associated with the profile [130]; sending funds or credits via the profile [130]; deducting funds or credits via the profile [130]; sending audio data [7] to the user [91]; sending image data [6] to the user [91]; sending audio data [7] to a contact, relative, or friend of the user [91]; sending image data [6] to a contact, relative, or friend of the user [91]; sending information to a contact, relative, or friend of the user [91] pertaining to a redemption option; sending funds or credits to an individual affiliated with the profile [130]; ordering a redemption option for a person associated with the profile [130], adding to a personal shopping list associated with the profile [130] of the user [91]; adding to a shopping list associated with an another individual associated with the profile [130]; adding to a gifting list associated with the profile [130] of the user [91]; adding to a gifting list associated with a contact, friend, or relative associated with the user [91] and/or profile [130] of the user [91]; adding to a personal wish list associated with the profile [130] of the user [91], and adding to a wish list associated with an another individual associated with the profile [130]. According to some embodiments, the profile [130] may comprise one or more of the group consisting of: a system profile, a social network [93] profile, and a vendor or selling entity [65] profile. According to some embodiments, the article may be selected from one or more of the group consisting of: an electronic device, a paper-based article, a receipt [20], a card [19], a software application [147], a disposable article, a tag, a display, a sign, a poster, an advertisement, a billboard, a mobile device [96], a food container, a container of a purchasable good or service [151], a purchasable good [151], a purchasable service [151], a redemption option [151], a browser [131], a system website [127], a third-party website [127] browser [131], and a kiosk [3] display means [109]. According to some embodiments, the instruction to a user [91] may comprise image data [6], wherein the image data [6] may comprise first indicia having a code thereon. According to some embodiments, the code may comprise a 1D barcode, a 2D barcode, a data matrix code, or a QR code. According to some embodiments, the code may be readable using a mobile device [96]. According to some embodiments, the code may be integrated with a system-based or third-party application [147]. According to some embodiments, when the code is read by the mobile device [96], the system-based or third-party application [147] may be configured to execute the step of updating or changing information relating to the profile [130] of the user [91] who reads the code using the mobile device [96]. According to some embodiments, the code may contain one or more of the group consisting of: redemption data [64], and vendor or selling entity [64] data. According to some embodiments, when scanned by a user's [91] mobile device [64], user data [8] and/or information relating to the user's [91] profile [130], such as the user's phone number [53] or email address [47], may be sent to a database [122, 129, 135, 137].

A system application [147] configured to be used with an article is further disclosed. According to some embodiments, the system application [147] may be configured to be used in concert with a device selected from one or more of the group consisting of: a vehicle hands-off voice command system, a mobile device [96], a system kiosk [3], and a computing device [95]. According to some embodiments, the article may have audio input means [103] for receiving audio input [4] from a user [91]. According to some embodiments, the article may comprise voice command interpretation software, wherein the system application [147] may be configured to interpret a spoken user [91] command, the command pertaining to a function to be performed by the system application [147]. According to some embodiments, the function to be performed by the system application [147] may pertain to making an update or change to information relating to a profile [130] of the user [91] of the system application [147]. According to some embodiments, the function to be performed by the system application [147] may pertain to a change in funds or credits associated with the user [91]. According to some embodiments, the change in funds or credits associated with the user [91] may comprise a change in payment data [10]. According to some embodiments, the change in payment data [10] of the viewer may comprise a change or update to at least one of the group consisting of: an account [48] balance, funds or credits associated with an account [17] or account ledger, digital wallet information, a cash or currency [11] balance or ledger, a credit card [12] balance, a debit card balance, an electronic benefits transfer (EBT) card [13] balance, a check [14] credit balance, a gift card [15] credit balance, an account balance associated with a gift card [15], a voucher credit balance, an account balance associated with a voucher, a vendor/entity [65] account balance, a gift certificate balance, a rewards/loyalty points balance, a frequent flyer miles balance, funds or credits associated with a coupon [16] or coupon code [16]; digital/electronic currency funds, a loan value, and funds or assets associated with a stock, fund, or tradable asset [81].

A method of universally accessing special benefits, offers, redemption awards, credits, features, privileges, or the like from a plurality of participating non-affiliated vendors or selling entities [65] is disclosed. According to some embodiments, the method may comprise: logging into a website [127] or application [128] of one of the plurality of non-affiliated participating vendors or selling entities [65], using system profile [130] information, wherein the system profile [130] information may comprise user data [8]; wherein the user data [8] may comprise payment data [10] and information pertaining to one or more contacts, relatives, or friends [145] associated with the profile [130]; accessing certain features of the website [127] or application [128]; making certain transactions pertaining to buying, trading, transferring, sending, or gifting one or more redemption options provided to the website [127]; and/or completing the certain transactions pertaining to buying, trading, transferring, sending, or gifting one or more redemption options, without necessarily performing one or more of the tasks selected from the group consisting of: manually providing payment data [10] to a data input field of the website [127] or application [128], manually providing location data [143] to a data input field of the website [127] or application [128], manually providing recipient data to a data input field of the website [127] or application [128], and manually creating a new user account login user name and/or password which is specific to the website [127] or application [128]. According to some embodiments, the method may comprise the step of selecting indicia to add a redemption option to a cart [133] for one or more contacts, relatives, or friends [145] associated with the profile [130]. According to some embodiments, the indicia may comprise information for identifying one or more contacts, relatives, or friends [145] associated with the profile [130]. According to some embodiments, the indicia may be configured to prompt and/or cause a selection to be made by a user input [4]; wherein the selection may be selected from one or more of the group consisting of: clicking the indicia, pressing the indicia, touching the indicia, dragging the indicia, right-clicking the indicia, tactilely engaging the indicia, and selecting the indicia by providing a voice command using appropriately-supported voice command software [147]. According to some embodiments, the method may comprise the step of selecting indicia to pay for, or otherwise checkout [132] a redemption option for one or more contacts, relatives, or friends [145] associated with the profile [130]. According to some embodiments, the method may comprise the step of selecting indicia to add a redemption option to a wish list or gift list of one or more contacts, relatives, or friends [145] associated with the profile [130]. According to some embodiments, the wish list may comprise a wish list belonging to the one or more contacts, relatives, or friends [145] associated with the profile [130]. According to some embodiments, the gift list may comprise a gift list belonging to the one or more contacts, relatives, or friends [145] associated with the profile [130]. According to some embodiments, the wish list and/or gift list may be independent from a wish list and/or gift list associated with the profile [130]. According to some embodiments, the redemption option may be accompanied by user data [8] associated with the user's [91] profile [130], and the gift list of the one or more contacts, relatives, or friends [145] associated with the profile [130] may comprise the redemption option and the user data [8]; thereby allowing the one or more contacts, relatives, or friends [145] associated with the profile [130] to know what the user [91] wants to receive. According to some embodiments, the method may comprise the step of selecting indicia to add a redemption option to a wish list or gift list of the user [91] associated with the profile [130], wherein the indicia may comprise information for identifying one or more contacts, relatives, or friends [145] associated with the profile [130]. According to some embodiments, the wish list may comprise a wish belonging to the user [91] of the profile [130], and the gift list may comprise a gift list belonging to the user [91] of the profile [130]; wherein the wish list and/or gift list belonging to the user [91] of the profile [130] may be independent from one or more wish lists and/or gift lists associated with another profile [130] belonging to the one or more contacts, relatives, or friends [145]. According to some embodiments, the redemption option may be accompanied by user data [8] associated with the another profile [130] belonging to the one or more contacts, relatives, or friends [145] associated with the user [91] profile [130], wherein the gift list of the user [91] may comprise the redemption option and the user data [8] pertaining to the one or more contacts, relatives, or friends [145]; thereby allowing the user [91] to know what the one or more contacts, relatives, or friends [145] associated with the profile [130] wants to receive. According to some embodiments, the method may comprise the step of selecting indicia to add a redemption option to a shopping list of one or more contacts, relatives, or friends [145] associated with the profile [130], the indicia may comprise information for identifying one or more contacts, relatives, or friends [145] associated with the profile [130]. According to some embodiments, the shopping list may comprise a shopping list belonging to the one or more contacts, relatives, or friends [145] associated with the profile [130]; wherein the shopping list may be independent from a shopping list associated with the profile [130]. According to some embodiments, the redemption option may be accompanied by user data [8] associated with the user's [91] profile [130], wherein the shopping list of the one or more contacts, relatives, or friends [145] associated with the profile [130] may comprise the redemption option and the user data [8]; thereby allowing the one or more contacts, relatives, or friends [145] associated with the profile [130] to know what the user [91] wants to shop for. According to some embodiments, the method may comprise the step of selecting indicia to add a redemption option to a shopping list of the user [91] associated with the profile [130], wherein the indicia may comprise information for identifying one or more contacts, relatives, or friends [145] associated with the profile [130], and wherein the indicia may be configured to cause a selection to be made by a user input [4]; wherein the selection may be selected from one or more of the group consisting of: clicking the indicia, pressing the indicia, touching the indicia, dragging the indicia, right-clicking the indicia, tactilely engaging the indicia, and selecting the indicia by providing a voice command using appropriately-supported voice command software [147]. According to some embodiments, the shopping list may comprise a shopping list belonging to the user [91] of the profile [130]; wherein the shopping list belonging to the user [91] of the profile [130] may be independent from one or more shopping lists associated with another profile [130] belonging to the one or more contacts, relatives, or friends [145]. According to some embodiments, the redemption option may be accompanied by user data [8] associated with the another profile [130] belonging to the one or more contacts, relatives, or friends [145] associated with the user [91] profile [130], wherein the shopping list of the user [91] may comprise the redemption option and the user data [8] pertaining to the one or more contacts, relatives, or friends [145]; thereby allowing the user [91] to know what the one or more contacts, relatives, or friends [145] associated with the profile [130] wants to shop for.

A method of utilizing a card [100, 200, 300, 400] is also disclosed. According to some embodiments, the method may comprise the step of: providing a system having a system database [129] and database manipulation means. According to some embodiments, the method may comprise the step of providing a system card [100a] which may comprise a system card account number [112] and an activation code [117] which is configured to be loaded or charged with funds or credits. According to some embodiments, the system card [100a] may comprise at least one function code [116] which is not to be confused with a 3-digit security code normally provided to the back of charge cards, banking cards, and the like. According to some embodiments, the system card account number [112] and activation code [117] may be stored on the system database [129]. According to some embodiments, the method may comprise the step of activating the system card [100a] when a user [91] of the system card [100a] calls or messages the system from a mobile device [96a] to be used with the system card [100a]. According to some embodiments, the method may comprise the step of providing the activation code [117]. According to some embodiments, the method may comprise the step of associating electronic address information associated with the mobile device [96a] to be used with the system card [100a], with the system card account number [112]. According to some embodiments, the method may comprise the step of performing a function associated with the at least one function code [116] when the at least one function code [116] is delivered to the system using the mobile device [96] to be used with the system card [100a]. According to some embodiments, the at least one function code [116] may comprise a short code address to which a message is to be sent. According to some embodiments, the at least one function code [116] may comprise a unique code which is to be included in a message to be sent to the system. According to some embodiments, the at least one function code [116] may comprise a plurality of different function codes [116] which represent different functions to be performed. According to some embodiments, the method may comprise the step of the system utilizing the at least one function code [116] to perform a function associated with the at least one function code [116]. According to some embodiments, the at least one function code [116] may relate to at least one of the group consisting of: sending funds or credits [102]; requesting funds or credits [103]; sending an item [104]; buying an item [105]; indicating, presenting, and/or posting a favorable opinion about an item [106]; adding an item to a wish list [107]; recommending an item [108]; requesting an item; receiving information pertaining a current account balance of funds or credits; receiving information pertaining to past buy transactions; receiving information pertaining to past send funds transactions; receiving information pertaining to past send item transactions; receiving information pertaining to past request funds transactions; receiving information pertaining to items on a wish list; receiving information pertaining to items having a favorable opinion by a user; and receiving information pertaining to recommended items. According to some embodiments, the method may comprise the step of a user [91] messaging the system from a mobile device [96a] to be used with the system card [100a] for future transactions. According to some embodiments, the step of a user [91] messaging the system may comprise the user [91] texting, or emailing the system from a mobile device [96a] to be used with the system card [100a] for future transactions. According to some embodiments, the at least one function code [116] may comprise a send funds code [102] which may be communicated to the system. According to some embodiments, when the send funds code [102] is communicated to the system in conjunction with recipient data and amount data, funds or credits associated with the system card account number [112] may be reduced by an amount pursuant to the amount data. According to some embodiments, the funds or credits associated with the system card account number [112] reduced by an amount pursuant to the amount data may be delivered in whole or in part to a recipient associated with the recipient data. According to some embodiments, the recipient data may comprise one or more of the group consisting of: a recipient email address, and a recipient 10-digit mobile device number. According to some embodiments, the at least one function code [116] may comprise a request funds code [103] which may be communicated to the system. According to some embodiments, when the request funds code [103] is communicated to the system in conjunction with requested sender data and amount data, funds or credits associated with the system card account number [112] of a requested sender associated with the requested sender data may be reduced by an amount pursuant to the amount data. According to some embodiments, the funds or credits associated with the system card account number [112] of a requested sender associated with the requested sender data reduced by an amount pursuant to the amount data may be delivered in whole or in part to the party communicating the request funds code [103] to the system. According to some embodiments, the requested sender data may comprise one or more of the group consisting of: a requested sender email address, and a requested sender 10-digit mobile device number. According to some embodiments, the at least one function code [116] may comprise a send item code [104] which may be communicated to the system. According to some embodiments, when the send item code [104] is communicated to the system in conjunction with recipient data and item data, funds or credits associated with the system card account number [112] may be reduced by an amount equivalent to a purchase price of an item associated with the item data plus anticipated shipping costs, if any. According to some embodiments, the item associated with the item data may be delivered in whole or in part to a recipient associated with the recipient data. According to some embodiments, the recipient data may comprise one or more of the group consisting of: a recipient email address, a recipient 10-digit mobile device number, and a recipient mailing address. According to some embodiments, the item data may comprise a unique system item code. According to some embodiments, the unique system item code may comprise an alphanumeric code. According to some embodiments, the item associated with the item data may be selected from one or more of the group consisting of: a good, a service, a product, an offering, a promotion, a donation, and a credit to purchase a good, service, or product. According to some embodiments, the item may be delivered to the recipient associated with the recipient data using electronic means. According to some embodiments, the item may be delivered to the recipient associated with the recipient data via one of the group consisting of: an email message, a text message (e.g., SMS/MMS), and a voicemail. According to some embodiments, the item may be physically delivered to the recipient associated with the recipient data. According to some embodiments, the at least one function code [116] may comprise a buy item code [105] which may be communicated to the system. According to some embodiments, when the buy item code [105] is communicated to the system in conjunction with recipient data and item data, funds or credits associated with the system card account number [112] may be reduced by an amount equivalent to a purchase price of an item associated with the item data plus anticipated shipping costs, if any. According to some embodiments, the item associated with the item data may be delivered in whole or in part to a recipient associated with the recipient data. According to some embodiments, the recipient data may comprise one or more of the group consisting of: a recipient email address, a recipient 10-digit mobile device number, and a recipient mailing address. According to some embodiments, the item data may comprise a unique system item code. According to some embodiments, the unique system item code may comprise an alphanumeric code. According to some embodiments, the item associated with the item data may be selected from one or more of the group consisting of: a good, a service, a product, an offering, a promotion, a donation, and a credit to purchase a good, service, item, or product. According to some embodiments, the item may be delivered to the recipient associated with the recipient data using electronic means. According to some embodiments, the item may be delivered to the recipient associated with the recipient data via one of the group consisting of: an email message, a text message (e.g., SMS/MMS), and a voicemail. According to some embodiments, the item may be physically delivered to the recipient associated with the recipient data. According to some embodiments, the recipient associated with the recipient data may be the person communicating the item data to the system. According to some embodiments, the recipient associated with the recipient data may comprise a contact, relative, or friend of the person communicating the item data to the system. According to some embodiments, the at least one function code [116] may comprise a like item code [106] which may be communicated to the system. According to some embodiments, when the like item code [106] is communicated to the system in conjunction with liking entity data and item data, a liking value associated with the system card account number [112] associated with the liking entity data may be updated to reflect a favorable opinion of an item associated with the item data. According to some embodiments, the liking entity data may comprise one or more of the group consisting of: a liking entity email address, a liking entity 10-digit mobile device number, and a liking entity mailing address. According to some embodiments, the item data may comprise a unique system item code. According to some embodiments, the unique system item code may comprise an alphanumeric code. According to some embodiments, the item associated with the item data may be selected from one or more of the group consisting of: a good, a service, a product, an offering, a promotion, a donation, and a credit to purchase a good, service, item, or product. According to some embodiments, the method may comprise the step of communicating information about an item associated with the item data. According to some embodiments, the step of communicating information may comprise the step of delivering to the liking entity associated with the liking entity data, the information about an item associated with the item data via one or more of the group consisting of: an email message, a text message (e.g., SMS/MMS), and a voicemail. According to some embodiments, the step of communicating information may comprise posting to the liking entity's social network, the information about an item associated with the item data. According to some embodiments, the liking entity associated with the liking entity data may comprise the person communicating the item data to the system. According to some embodiments, the liking entity associated with the liking entity data may comprise a contact, relative, or friend of the person communicating the item data to the system. According to some embodiments, the at least one function code [116] may comprise an add item to wish list code [107] which may be communicated to the system. According to some embodiments, when the add item to wish list code [107] is communicated to the system in conjunction with wishing entity data and item data, a wishing value associated with the system card account number [112] associated with the wishing entity data may be updated to reflect a desire to have an item associated with the item data. According to some embodiments, the wishing entity data may comprise one or more of the group consisting of: a wishing entity email address, a wishing entity 10-digit mobile device number, and a wishing entity mailing address. According to some embodiments, the item data may comprise a unique system item code. According to some embodiments, the unique system item code may comprise an alphanumeric code. According to some embodiments, the item associated with the item data may be selected from one or more of the group consisting of: a good, a service, a product, an offering, a promotion, a donation, and a credit to purchase a good, service, item, or product. According to some embodiments, wherein the method may comprise the step of communicating information about an item associated with the item data. According to some embodiments, the step of communicating information may comprise delivering to the wishing entity associated with the wishing entity data, the information about an item associated with the item data via one or more of the group consisting of: an email message, a text message (e.g., SMS/MMS), and a voicemail. According to some embodiments, the step of communicating information may comprise posting to the wishing entity's social network, the information about an item associated with the item data. According to some embodiments, the wishing entity associated with the wishing entity data may comprise the person communicating the item data to the system. According to some embodiments, the wishing entity associated with the wishing entity data may comprise a contact, relative, or friend of the person communicating the item data to the system. According to some embodiments, the at least one function code [116] may comprise a recommend item code [108] which may be communicated to the system. According to some embodiments, when the recommend item code [108] is communicated to the system in conjunction with recommending entity data and item data, a recommending value associated with the system card account number [112] associated with the recommending entity data may be updated to reflect a desire to recommend an item associated with the item data. According to some embodiments, the recommending entity data may comprise one or more of the group consisting of: a recommending entity email address, a recommending entity 10-digit mobile device number, and a recommending entity mailing address. According to some embodiments, the item data may comprise a unique system item code. According to some embodiments, the unique system item code may comprise an alphanumeric code. According to some embodiments, the item associated with the item data may be selected from one or more of the group consisting of: a good, a service, a product, an offering, a promotion, a donation, and a credit to purchase a good, service, item, or product. According to some embodiments, wherein the method may comprise the step of communicating information about an item associated with the item data. According to some embodiments, the step of communicating information may comprise delivering to the recommending entity associated with the recommending entity data, the information about an item associated with the item data via one or more of the group consisting of: an email message, a text message (e.g., SMS/MMS), and a voicemail. According to some embodiments, the step of communicating information may comprise posting to the recommending entity's social network, the information about an item associated with the item data. According to some embodiments, the recommending entity associated with the recommending entity data may comprise the person communicating the item data to the system. According to some embodiments, the recommending entity associated with the recommending entity data may comprise a contact, relative, or friend of the person communicating the item data to the system.

A method of performing functions from a mobile device [96] is also disclosed. According to some embodiments, the method may comprise the step of: providing a system having a system database [129] and a system website [127]. According to some embodiments, the method may comprise the step of providing a system account number [112] which is configured to be associated with funds or credits, wherein a user [91] may add funds or credits to the system account number [112] using online payment receiving means provided to the system website [127]. According to some embodiments, the method may comprise the step of providing at least one function code [116] to a user [91] of the system card account number [112]. According to some embodiments, the method may comprise the step of the system card account number [112] and the least one function code [116] being stored on the system database [129] and associated with each other in the system database [129]. According to some embodiments, the method may comprise the step of performing a function associated with the function code [116] when the function code [116] may be delivered to the system using the mobile device [96] to be used with the system card [100a]. According to some embodiments, the at least one function code [116] may comprise a short code address to which a message is to be sent. According to some embodiments, the at least one function code [116] may comprise a unique code which is to be included in a message to be sent to the system. According to some embodiments, the at least one function code [116] may comprise a plurality of different function codes [116] which represent different functions to be performed. According to some embodiments, the method may comprise the step of utilizing the at least one function code [116] to perform at least one function associated with the at least one function code [116]. According to some embodiments, the at least one function code [116] may relate to at least one of the group consisting of: sending funds or credits [102], requesting funds or credits [103]; sending an item [104]; buying an item [105]; indicating, presenting, or posting a favorable opinion about an item [106]; adding an item to a wish list [107]; recommending an item [108]; requesting an item; receiving information pertaining a current account balance of funds or credits; receiving information pertaining to past buy transactions; receiving information pertaining to past send funds transactions; receiving information pertaining to past send item transactions; receiving information pertaining to past request funds transactions; receiving information pertaining to items on a wish list; receiving information pertaining to items having a favorable opinion by a user; and receiving information pertaining to recommended items. According to some embodiments, the method may comprise the step of a user [91] messaging the system from a mobile device [96a] to be used with the system account number [112] for future transactions, to activate the system account number [112]. According to some embodiments, the step of a user [91] messaging the system may comprise the user [91] calling, texting, or emailing the system from a mobile device [96a] to be used with the system account number [112] for future transactions. According to some embodiments, the method may comprise the step of a user [91] logging into the system website [127] using third party login data. According to some embodiments, the third party login data may comprise a user email address associated with a third-party website and a password or passphrase associated with the third-party website. According to some embodiments, the third-party website may comprise a vendor or selling entity website, a financial services website, or a social network site [93].

A method for sending funds or credits from a first user [91] to a second user [92] is disclosed. According to some embodiments, the method for sending funds or credits from a first user [91] to a second user [92] may not require the first user [91] or second user [92] to have a bank account, a credit card account, a user login name and password, and/or a smart phone or proprietary mobile application. According to some embodiments, the method may comprise one or more of the following steps: a first user [91] purchasing a first user system card [100a] at a system card distributer; the first user [91] adding funds to the first user system card [100a]; the first user [91] calling or messaging a system and providing a function code [116], second user [92] data, and an amount of funds or credits to be sent; and/or the second user [92] receiving at least a portion of the amount of funds or credits to be sent. According to some embodiments, other than for the step of a first user [91] purchasing a first user system card [100a] at a system card distributer, no additional human interaction is necessary. According to some embodiments, the at least a portion of the amount of funds or credits received by the second user [92] may be instantly utilized in commerce. According to some embodiments, the at least a portion of the amount of funds or credits received by the second user [92] may be utilized in commerce once the second user [92] purchases a second user system card [100b] at a system card distributer. According to some embodiments, the amount of funds or credits to be sent may be delivered to the second user [92] in a single text message from the first user's mobile device [96a]. According to some embodiments, the amount of funds or credits to be sent may be delivered in a single phone call from the first user's mobile device [96a] and entering the function code [116], second user [92] data, and an amount of funds or credits to be sent. According to some embodiments, the amount of funds or credits to be sent may be delivered in a single phone call from the first user's mobile device [96a] by entering only the function code [116], second user [92] data, and an amount of funds or credits to be sent. According to some embodiments, the second user [92] data may comprise one of the group consisting of: the second user's [92] email address, and the second user's [92] 10-digit mobile device number. According to some embodiments, a method for a second user [92] receiving funds or credits from a first user [91] without secondary human interactions, without having a bank account, without a credit card account, without requiring a user login name and password, and without requiring a smart phone or proprietary mobile application may comprise a first user [91] messaging the second user's [92] mobile device [96b] directly or via a system.

A method for sending an item from a first user [91] to a second user [92] without the first user [91] having a bank account, without a credit card account, without requiring a user login name and/or password, and without requiring a smart phone or proprietary mobile application, is disclosed. According to some embodiments, the method may comprise one or more of the following steps: a first user [91] purchasing a first user system card [100a] at a system card distributer; the first user [91] adding funds to the first user system card [100a]; the first user [91] calling or messaging a system and providing a function code [116], second user [92] data, and an item code pertaining to an item to be sent; and/or the second user [92] receiving the item to be sent. According to some embodiments, other than for the step of a first user [91] purchasing a first user system card [100a] at a system card distributer, no additional human interaction may be necessary. According to some embodiments, the item may be received by the second user [92] and may be instantly utilized in commerce. According to some embodiments, the item may be received by the second user [92] and may be utilized in commerce once the second user [92] purchases a second user system card [100b] at a system card distributer. According to some embodiments, the item may be delivered to the second user [92] in a single text message from the first user's mobile device [96a]. According to some embodiments, the item may be delivered in a single phone call from the first user's mobile device [96a] entering only the function code [116], second user [92] data, and an amount of funds or credits to be sent. According to some embodiments, the second user [92] data may comprise one or more of the group consisting of: the second user's [92] email address, and the second user's [92] 10-digit mobile device number. According to some embodiments, the item may comprise a physical item to be delivered, and the second user data may comprise the second user's [92] mailing address. According to some embodiments, the method may comprise the second user [92] receiving the item via electronic delivery means to the second user's [92] mobile device [96b]. According to some embodiments, the electronic delivery means may be selected from one or more of the group consisting of: an email message, a text message (e.g., SMS/MMS), and a voicemail.

An article [100, 200, 300, 400] is also disclosed. According to some embodiments, the article may comprise a system account number [112] which is configured to be loaded or charged with funds or credits. According to some embodiments, the article may comprise at least one function code [116]. According to some embodiments, the system account number [112] may be stored on a system database [129]. According to some embodiments, the article may comprise at least one function code [116] unique to the system account number [112]. According to some embodiments, when the at least one function code [116] is delivered to the system using the mobile device [96] associated with the system card [100a], along with either an item code or amount of funds or credits, a function may be performed. According to some embodiments, the function may comprise a change to data associated with the system account number [112].

A card [100, 200, 300, 400] to be used for making purchases and at least one of giving, receiving, liking, adding, recommending, and sharing is disclosed. According to some embodiments, the card [100, 200, 300, 400] may comprise: a system account number [112], and at least one of a send funds code [102], a request funds code [103], a send item code [104], a buy item code [105], a like item code [106], an add item to wish list code [107], and a recommend to a friend code [108]. According to some embodiments, the card may comprise a device selected from one or more of the group consisting of: a magnetic stripe, a chip, and an RFID device. According to some embodiments, an article which may be used with the card [100, 200, 300, 400] is disclosed, wherein the card [100, 200, 300, 400] may comprise one or more of the group consisting of: a send item code [104], a buy item code [105], a like item code [106], an add item to wish list code [107], and a recommend to a friend code [108]. According to some embodiments, the article to be used with the card [100, 200, 300, 400] may comprise a unique item code which may be used with information provided to the card [100, 200, 300, 400] and a mobile device [96]. According to some embodiments, the article may be selected from one or more of the group consisting of: a paper billboard, an electronic billboard image or screenshot, a television advertisement image or screenshot, a television program image or screenshot, an internet advertisement image or screenshot, a streaming media audio clip, a streaming media video clip, a streaming media image, a radio advertisement sound clip, a radio program sound clip, a sign, a display, a tag, a label, a receipt, an online marketplace, a website image or screenshot, a product, a good, a pamphlet, a promotional item, a magazine, a newspaper, a periodical, an electronic image, a physical image, a paper-based item, a container, a box, and a packaging material.

A method of utilizing funds or credits associated with a card [100, 200, 300, 400] of a user [91] is further disclosed. According to some embodiments, the method may comprise any one or more of the following steps: associating the user funds or credits associated with a card [100, 200, 300, 400] of a user [91] with a mobile device [96] of the user [91], wherein the mobile device [96] of the user [91] may be configured with voice-command software; providing one or more instructions to one or more roadside displays or displays viewable from a road; receiving a command from the user [91], via the mobile device [96] of the user [91], the command from the user [91] relating to the one or more instructions; interpreting the command from the user [91]; processing the command from the user [91]; and/or performing a task associated with the command from the user [91]. According to some embodiments, a plurality of commands may be made from the user [91], via the mobile device [96] of the user [91], the plurality of commands from the user [91] relating to the one or more instructions; wherein the step of interpreting the command from the user [91] may comprise interpreting the plurality of commands from the user [91]. According to some embodiments, the step of processing the command from the user [91] may comprise processing the plurality of commands from the user [91]. According to some embodiments, the step of performing a task associated with the command from the user [91] may comprise performing a plurality of tasks associated with the plurality of commands from the user [91]. According to some embodiments, the command from the user [91] may comprise a speech-enabled command. According to some embodiments, the command and instructions may involve one or more of the following: the user [91] buying an item for the user [91]; the user [91] buying an item, good, service, promotion, or offer for another individual [92] or organization, such as a contact, relative, or friend of the user [91]; the user [91] sending an item, good, service, promotion, or offer for another individual [92] or organization, such as a contact, relative, or friend of the user [91]; the user [91] performing a social network function; the user [91] adding an item, good, service, promotion, or offer to a wish list; the user recommending an item, good, service, promotion, or offer to another individual [92]; and the user sharing an item, good, service, promotion, or offer to another individual [92]. According to some embodiments, the one or more instructions may comprise instructions regarding a geographic zone or time-based limit; wherein the instructions may not be processed if the user [91] exits the geographic zone or exceeds the time-based limit. According to some embodiments, the mobile device [96] of the user [91] may comprise a system application which is configured to receive, interpret, and/or assist with delivery of the command from the user [91]. According to some embodiments, the system application may be configured to utilize location data of the user [91], in particular, location data containing the user's [91] current mobile position, to accept, interpret, validate, and execute the command from the user [91]. According to some embodiments, the system application may contain data relating to the geographic position or location of the one or more instructions provided to the one or more roadside displays or displays viewable from a road; or otherwise is configured to remotely access data relating to the geographic position or location of the one or more instructions provided to the one or more roadside displays or displays viewable from a road. According to some embodiments, the one or more roadside displays or displays viewable from a road may comprise a plurality of roadside displays or displays viewable from a road; each of the plurality of roadside displays or displays viewable from a road being geographically spaced apart and containing one or more instructions; wherein the system application may contain data relating to the geographic positions or locations of the one or more instructions provided to each of the plurality of roadside displays or displays viewable from a road, or is otherwise configured to remotely access data relating to the geographic positions or locations of the one or more instructions provided to each of the plurality of roadside displays or displays viewable from a road. According to some embodiments, the one or more instructions provided to each of the plurality of roadside displays or displays viewable from a road may comprise instructions regarding a geographic zone or time-based limit; wherein the instructions may not be processed by the system application if the user [91] exits the geographic zone or exceeds the time-based limit.

A mobile application configured to utilize digital wallet information or funds or credits associated with a card [100, 200, 300, 400] of a user [91] is further disclosed. According to some embodiments, the mobile application may be configured to be installed on a mobile device [96] of the user [91]. According to some embodiments, the mobile device [96] may be configured with voice-command software. According to some embodiments, the mobile application may comprise: means for determining the user's [91] current mobile position; means for receiving a user [91] command relating to one or more instructions provided to one or more roadside displays or displays viewable from a road, the command from the user [91] relating to the one or more instructions; means for interpreting the command from the user [91]; means for processing the command from the user [91]; and/or means for performing a task associated with the command from the user [91]. According to some embodiments, the means for receiving a user [91] command may be configured to receive a plurality of commands made by the user [91], via the mobile device [96] of the user [91]. According to some embodiments, the plurality of commands from the user [91] may relate to the one or more instructions. According to some embodiments, the means for interpreting the command from the user [91] may be configured to interpret the plurality of commands from the user [91]. According to some embodiments, the means for processing the command from the user [91] may be configured to process the plurality of commands from the user [91]. According to some embodiments, the means for performing a task associated with the command from the user [91] may be configured to perform a plurality of tasks associated with the plurality of commands from the user [91]. According to some embodiments, the command from the user [91] may comprise a speech-enabled command. According to some embodiments, the command and instructions may involve one or more of the following: the user [91] buying an item for the user [91]; the user [91] buying an item, good, service, promotion, or offer for another individual [92] or organization, such as a contact, relative, or friend of the user [91]; the user [91] sending an item, good, service, promotion, or offer for another individual [92] or organization, such as a contact, relative, or friend of the user [91]; the user [91] performing a social network function; the user [91] adding an item, good, service, promotion, or offer to a wish list; the user recommending an item; good, service, promotion, or offer to another individual [92]; and the user sharing an item, good, service, promotion, or offer to another individual [92]. According to some embodiments, the one or more instructions may comprise instructions regarding a geographic zone or time-based limit. According to some embodiments, the instructions may not be processed if the user [91] exits the geographic zone or exceeds the time-based limit. According to some embodiments, the mobile application may be configured to receive, interpret, and/or assist with delivery of the command from the user [91]. According to some embodiments, the mobile application may be configured to utilize location data of the user [91], for example, location data containing the user's [91] current mobile position, to accept, interpret, validate, and execute the command from the user [91].

According to some embodiments, the mobile application may contain data relating to the geographic position or location of the one or more instructions provided to the one or more roadside displays or displays viewable from a road, or may otherwise be configured to remotely access data relating to the geographic position or location of the one or more instructions provided to the one or more roadside displays or displays viewable from a road. According to some embodiments, the one or more roadside displays or displays viewable from a road may comprise a plurality of roadside displays or displays viewable from a road; each of the plurality of roadside displays or displays viewable from a road being geographically spaced apart and containing one or more instructions; wherein the system application may contain data relating to the geographic positions or locations of the one or more instructions provided to each of the plurality of roadside displays or displays viewable from a road, or may otherwise be configured to remotely access data relating to the geographic positions or locations of the one or more instructions provided to each of the plurality of roadside displays or displays viewable from a road. According to some embodiments, the one or more instructions provided to each of the plurality of roadside displays or displays viewable from a road may comprise instructions regarding a geographic zone or time-based limit; wherein the instructions may not be processed by the mobile application if the user [91] exits the geographic zone or exceeds the time-based limit.

A mobile application configured to be utilized with a card [100, 200, 300, 400] is disclosed. According to some embodiments, the card may be affiliated with a user [91] of the mobile application. According to some embodiments, the mobile application may be downloadable to the user's [91] mobile device [96]. According to some embodiments, the card may have a 1D barcode, a 2D barcode, a data matrix code, or a QR code, provided thereon. According to some embodiments, the mobile application may be used to perform a verification step during a transaction. According to some embodiments, the mobile application may comprise a user interface configured with an image capture frame. According to some embodiments, the user may take an image of the 1D barcode, a 2D barcode, a data matrix code, or a QR code, provided on the card [100, 200, 300, 400] utilizing the image capture frame. According to some embodiments, upon taking an image of the 1D barcode, a 2D barcode, a data matrix code, or a QR code, provided on the card [100, 200, 300, 400], the mobile application may validate the transaction and/or process the transaction.

According to some embodiments, the mobile application configured to be utilized with a card [100, 200, 300, 400] of a user [91] may comprise an amount field. According to some embodiments, the mobile application may comprise an item field. According to some embodiments, the mobile application may comprise a send icon. According to some embodiments, the mobile application may comprise one or more of the following icons: a buy icon, a gift icon, an icon indicating an option to add an item to a wish list, an icon indicating an option to provide a favorable opinion, an icon indicating an option to perform a social network function, an icon indicating an option to share via SMS or MMS protocol, an icon indicating an option to share via email, an icon indicating an option to share via a social network group or social network profile, a request icon, a wish list icon, an icon indicating an ability to view historical transactions, an icon indicating an ability to view available credits, an icon indicating an ability to view an account balance. According to some embodiments, the mobile application may be configured to auto-populate the item field by engaging or otherwise interacting with a wish list import icon. According to some embodiments, the wish list import icon, when engaged or otherwise interacted with, may display a list of items, goods, services, promotions, or offers associated with a wish list maintained within the system application. According to some embodiments, the mobile application may be configured with pop-up windows, wherein when any one of the gift icon, the icon indicating an option to perform a social network function, the icon indicating an option to share via SMS or MMS protocol, the icon indicating an option to share via email, or the icon indicating an option to share via a social network group or social network profile, is engaged or otherwise interacted with, a pop-up window containing a list of contacts, relatives, or friends may be displayed. According to some embodiments, each of the contacts, relatives, or friends contained within the list may be selected. According to some embodiments, when the send icon is engaged or otherwise interacted with, all of the selected contacts, relatives, or friends are sent one or more of the following: funds, credits, or information pertaining to one or more items, goods, services, promotions, or offers. According to some embodiments, the funds or credits sent may comprise the amount of the value provided in the amount field. According to some embodiments, the information pertaining to one or more items, goods, services, promotions, or offers sent may be affiliated with an item code provided in the item field. According to some embodiments, the method may be configured with means to deliver a message, image data, and audio data.

A mobile application according to some embodiments may be configured to allow a first user [91] to physically shop for items, products, goods, or services in a brick and mortar facility. According to some embodiments, the mobile application may be configured to allow a first user [91] to add the items, products, goods, or services to a shopping list by entering SKU, UPC, or item number information for each of the items, products, goods, or services or by scanning a machine-readable code associated with SKU, UPC, or item number information for each of the items, products, goods, or services. According to some embodiments, the mobile application may comprise a gifting module. According to some embodiments, the user [91] may, via the gifting module, pay for the shopping list and deliver the shopping list to one or more contacts, friends, relatives, or other users [92] via SMS messaging protocol, MMS messaging protocol, email protocol, voicemail, or via a social network platform. According to some embodiments, the voicemail may contain digital audio data which is machine readable. According to some embodiments, the one or more contacts, friends, relatives, or other users [92] receiving the voicemail may present the phone adjacent a P-O-S checkout terminal of a vendor or selling entity affiliated with the items, products, goods, or services stored on the shopping list, and play the voicemail adjacent the terminal. According to some embodiments, the terminal may receive the digital audio data played adjacent the terminal, may interpret the digital audio data, may process the digital audio data, may generate a list of redeemable credits on a display connected with the terminal, and may deduct the redeemable credits from the subtotal or total shopping bill of the one or more contacts, friends, relatives, or other users [92]. According to some embodiments, the redeemable credits may only be deducted if the respective items, products, goods, or services associated with the digital audio data are scanned by the terminal. According to some embodiments, a total amount of the redeemable credits deducted from the subtotal or total shopping bill of the one or more contacts, friends, relatives, or other users [92] may equal the amount paid by the first user [91] during gifting. According to some embodiments, an MMS message may be used to deliver the shopping list to the one or more contacts, friends, relatives, or other users [92]. According to some embodiments, the MMS message contains digital audio data which is machine readable. According to some embodiments, the one or more contacts, friends, relatives, or other users [92] receiving the MMS message may present the phone adjacent a P-O-S checkout terminal of a vendor or selling entity affiliated with the items, products, goods, or services stored on the shopping list, and may play the MMS message adjacent the terminal. According to some embodiments, the terminal may receive the digital audio data played adjacent the terminal, may interpret the digital audio data, may process the digital audio data, may generate a list of redeemable credits on a display connected with the terminal, and may deduct the redeemable credits from the subtotal or total shopping bill of the one or more contacts, friends, relatives, or other users [92]. According to some embodiments, the redeemable credits may only be deducted if the respective items, products, goods, or services associated with the digital audio data are scanned by the terminal. According to some embodiments, a total amount of the redeemable credits deducted from the subtotal or total shopping bill of the one or more contacts, friends, relatives, or other users [92] may equal the amount paid by the first user [91] during gifting. According to some embodiments, the gifted shopping list information is delivered electronically via SMS messaging protocol, MMS messaging protocol, email protocol, or via a social network platform. According to some embodiments, the gifted shopping list information may comprise image data. According to some embodiments, the image data may comprise text. According to some embodiments, the text may comprise a redemption code. According to some embodiments, the image data may be machine readable or otherwise comprise machine-readable indicia. According to some embodiments, the image data may comprise a 1D barcode, a 2D barcode, a data matrix code, or a QR code which is scannable by a P-O-S checkout terminal.

A method of gifting at a brick and mortar facility is further disclosed. According to some embodiments, the method may comprise one or more of the following steps: selecting an item, wherein the item may be selected from one or more of the group consisting of: a product, an item, a good, and a service; instructing an employee attending a payment terminal to gift the selected item; providing the payment terminal with recipient information; and/or paying for the selected item, without receiving the item. According to some embodiments, the provided recipient information may comprise at least one of the group consisting of: a mobile phone number, email address, profile number, username, and a screen name. According to some embodiments, the method may comprise the step of electronically delivering the item to a recipient using the provided recipient information. According to some embodiments, the step of electronically delivering the item may comprise delivering redemption information via SMS, MMS, or electronic mail. According to some embodiments, the step of electronically delivering the item may comprise delivering a pre-paid voucher, gift certificate, store credit, ticket, or coupon for the item. According to some embodiments, the method may comprise the step of providing a receipt showing the item and/or the provided recipient information. According to some embodiments, the step of providing the payment terminal with recipient information may be conducted by the employee. According to some embodiments, the step of providing the payment terminal with recipient information may be conducted by a person performing the step of paying for the selected item. According to some embodiments, the payment terminal may comprise a user interface accessible by the person performing the step of paying for the selected item, the user interface being configured to receive input from the person performing the step of paying for the selected item. According to some embodiments, the user interface may comprise at least one of the group consisting of: a touch screen, a touch pad, a keypad, a keyboard, and a voice-command unit.

A webpage comprising machine-readable indicia is further disclosed. According to some embodiments, the machine-readable indicia may be scannable. According to some embodiments, when the machine-readable indicia is scanned using a mobile device configured with a software application, the software application may perform or facilitate the performance of a function. According to some embodiments, the webpage is a shopping page of an online marketplace. According to some embodiments, the webpage is a secure checkout page for accepting payment. According to some embodiments, the function performed by the software application may comprise one or more of the group consisting of: a social function, a payment function, a gifting function, a recommendation function, and a favorable opinion communication.

A method of paying for an online purchase is further disclosed. According to some embodiments, the method may comprise one or more of the following steps: providing a webpage which may comprise a purchasable item selected from one or more of the group consisting of: a product, a good, an item, and a service; displaying machine-readable indicia on the webpage; scanning the machine-readable indicia on the webpage using a mobile device configured with a software application; and/or paying for the purchasable item using the mobile device. According to some embodiments, the webpage may comprise a shopping page of an online marketplace. According to some embodiments, the webpage may comprise a secure checkout page for accepting payment. According to some embodiments, the software application may facilitate the step of paying for the purchasable item. According to some embodiments, the purchasable item may comprise a gift, and contact information which is representative of an intended recipient of the gift provided to the mobile device via the software application. According to some embodiments, the contact information may be stored on the mobile device's hard drive or SIM card in a mobile contacts list. According to some embodiments, the contact information may be stored on the mobile application or a website affiliated with the mobile application. According to some embodiments, the mobile application or website affiliated with the mobile application may comprise a social networking mobile application or a social networking website affiliated with the mobile application, respectively. According to some embodiments, the method may comprise a user-fillable field on the webpage which is configured for entering a one-time password, pass code, or passphrase. According to some embodiments, the method may comprise the step of delivering a one-time password, pass code, or passphrase to the mobile device after the step of scanning the machine-readable indicia, and entering the one-time password, pass code, or passphrase delivered to the mobile device into the user-fillable field.

A method of paying for an online purchase is further disclosed. According to some embodiments, the method may comprise one or more of the following steps: providing a webpage which may comprise a purchasable item; wherein the purchasable item may be selected from one or more of the group consisting of: a product, a good, an item, or a service; displaying instructions on the webpage, wherein the instructions may comprise SMS and/or MMS messaging instructions and/or an electronic address; and/or following the instructions provided on the webpage using a mobile device. According to some embodiments, the electronic address may be selected from one or more of the group consisting of: a short code, a phone number, and an email address. According to some embodiments, the step of following the instructions provided on the webpage may comprise texting an alpha-numeric code to the electronic address to facilitate a function. According to some embodiments, the function may comprise one or more of the group consisting of: a social function, a payment function, a gifting function, a recommendation function, and a favorable opinion communication. According to some embodiments, the function may comprise a gifting function, and the alpha-numeric code may comprise recipient information selected from one or more of the group consisting of: a recipient mobile phone number, a recipient email address, a recipient profile number, a recipient username, and a recipient screen name. According to some embodiments, the function may comprise a payment function, and the alpha-numeric code may comprise purchaser information selected from one or more of the group consisting of: purchaser financial information, purchaser email address information, purchaser physical address information, a purchaser username, and a purchaser screen name. According to some embodiments, the function may comprise a payment function. According to some embodiments, the method may comprise the step of associating funds or credits with the mobile device. According to some embodiments, the step of associating funds or credits with the mobile device may comprise loading funds or credits to a digital wallet of the mobile device. According to some embodiments, the step of loading funds or credits to a digital wallet of the mobile device may comprise providing banking, credit card, billing, or financial information to the digital wallet of the mobile device. According to some embodiments, the method may comprise the step of purchasing a card and activating the card by calling a number provided to the card and/or card packaging using the mobile device. According to some embodiments, the step of associating funds or credits with the mobile device may comprise associating funds or credits associated with the purchased card to the mobile device number during or after the step of activating the card. According to some embodiments, the card may be selected from one or more of the group consisting of: a gift card which is purchasable at a brick-and-mortar facility, and an electronic gift card (for example, an eGift certificate, without limitation). According to some embodiments, the method may comprise the step of purchasing credits online, and providing the mobile device's number during the transaction; wherein according to some embodiments, the step of associating funds or credits with the mobile device may comprise associating funds or credits associated with the credits purchased online with the mobile device number. According to some embodiments, the method may comprise the step of providing a user-fillable field on the webpage configured for entering a one-time password, pass code, or passphrase. According to some embodiments, the method may comprise the step of delivering a one-time password, pass code, or passphrase to the mobile device after the step of following the instructions provided on the webpage, and entering the one-time password, pass code, or passphrase delivered to the mobile device into the user-fillable field.

A method of paying for an online purchase is also disclosed. According to some embodiments, the method may comprise one or more of the following steps: providing a webpage which may comprise a purchasable item selected from one or more of the group consisting of: a product, an item, a good, and a service; displaying instructions on the webpage pertaining to an audible phrase; and/or using a mobile device configured with a software application including voice-command software to pay for the purchasable item. According to some embodiments, the step of using a mobile device to pay for the purchasable item may comprise saying a command corresponding to the displayed instructions while the software application is active or otherwise running. According to some embodiments, the step of saying a command may comprise a verb suggesting a gifting function or a purchase function. According to some embodiments, the step of saying a command may comprise a verb suggesting a gifting function, wherein contact information which is representative of an intended recipient, is spoken. According to some embodiments, the contact information may comprise a name. According to some embodiments, the contact information spoken may be stored on the mobile device. According to some embodiments, the contact information spoken may be stored on the mobile device's hard drive or SIM card in a mobile contacts list. According to some embodiments, the contact information spoken may be stored on the mobile application or a website affiliated with the mobile application. According to some embodiments, the mobile application or website affiliated with the mobile application may comprise a social networking or social media mobile application or a social networking or social media website affiliated with the mobile application, respectively. According to some embodiments, the method may comprise a user-fillable field on the webpage configured for entering a one-time password, pass code, or passphrase. According to some embodiments, the method may comprise delivering a one-time password, pass code, or passphrase to the mobile device after the step of using a mobile device configured with a software application including voice-command software to pay for the purchasable item, and entering the one-time password, pass code, or passphrase delivered to the mobile device into the user-fillable field.

Indicia is further disclosed. According to some embodiments, the indicia may comprise or otherwise employ a machine-readable indicia portion. According to some embodiments, the indicia may comprise a secondary non-machine-readable indicia portion surrounding or forming a portion of the machine-readable indicia portion. According to some embodiments, the secondary non-machine-readable indicia portion may convey a function that may occur when the machine-readable indicia is scanned with hardware equipped with software. According to some embodiments, the secondary non-machine-readable indicia portion may comprise one or more of the group consisting of: a portion of a social network logo, a portion of a search engine logo, a portion of a currency symbol, a portion of a present, and a portion of an envelope, without limitation.

Machine-readable indicia which may comprise embedded information is also disclosed. According to some embodiments, the embedded information may comprise information selected from one or more of the group consisting of: an item identification code, pricing information, vendor identification information, function information, and social network information. According to some embodiments, the item identification code may pertain to a particular product, good, or service, which is different from an item identification code pertaining to another particular product, good, or service. According to some embodiments, the item may be selected from one or more of the group consisting of: a product, an item, a good, and a service. According to some embodiments, the pricing information may comprise a monetary or credit value equivalent to an item associated with the item identification code. According to some embodiments, the vendor identification information may comprise alpha-numeric or character information which represents a particular vendor or selling entity; wherein the vendor identification information may comprise at least one of the group consisting of: a vendor identification number, a vendor payment address, a vendor profile ID, and a vendor webpage address. According to some embodiments, the function information may comprise alpha-numeric or character information which may pertain to one of the group consisting of: a social function, a payment function, a gifting function, a recommendation function, and a favorable opinion communication. According to some embodiments, the social network function information may comprise alpha-numeric or character information which may pertain to one of the group consisting of: a post, a favorable opinion communication, a payment function, a gifting function, and a recommendation function. According to some embodiments, the embedded information may comprise a character string. According to some embodiments, the character string may comprise one or more of (e.g., at least two of) the group consisting of: an item identification code, pricing information, vendor identification information, function information, and social network information. According to some embodiments, the machine-readable indicia may be associated with a unique item, wherein the machine-readable indicia is scannable using a mobile device configured with a mobile application configured to display a list of options and also configured to execute one or more respective functions associated with the list of options; and wherein when the machine-readable indicia is scanned using the mobile device, the mobile application of the mobile device may display a list of options. According to some embodiments, the list of options may comprise one or more of the options selected from the group consisting of: an option to buy an item, an option to gift an item, and an option to share a favorable opinion of an item. According to some embodiments, the item may be selected from one or more of the group consisting of: a product, an item, a good, and a service.

A login page is further disclosed. According to some embodiments, the login page may comprise a QR code, 1 dimensional barcode, 2 dimensional barcode, or other machine-readable indicia. According to some embodiments, the login page may comprise a web page. According to some embodiments, the login page may comprise a field for a one-time use PIN, password, pass code, alpha-numeric key, or passphrase to be entered. According to some embodiments, the one-time use PIN, password, pass code, alpha-numeric key, or passphrase may be delivered via one or more of the group consisting of: a system mobile application, an electronic mail communication, a mobile messaging application, a short message service (SMS) communication, and a multimedia messaging service (MMS) communication.

A login web page, according to some embodiments, may comprise at least one machine-generated string of characters, numbers, or letters. According to some embodiments, the login page may comprise a web page. According to some embodiments, the login web page may comprise instructions to text the at least one machine-generated string of characters, numbers, or letters to a provided electronic address to gain access to a secure webpage. According to some embodiments, the electronic address may comprise one or more of the electronic addresses selected from the group consisting of: an email address, a short code, a long code, and a phone number. According to some embodiments, the electronic address may comprise a short code, a long code, or a phone number. According to some embodiments, the electronic address may also be machine-generated. According to some embodiments, the machine-generated string of characters, numbers, or letters cannot be interpreted by a machine and may be designed to be read and understood by a human to reduce ability for a user to run a script to login automatically. According to some embodiments, the machine-generated string of characters, numbers, or letters and the machine-generated electronic address cannot be interpreted by a machine and is designed to be read and understood by a human to reduce ability for a user to run a script to login automatically. According to some embodiments, the login web page may comprise a field for entering and receiving one or more of the group consisting of: a phone number, an email address, an account password, and one or more portions of information provided to a purchasable card.

A system configured for allowing a first user to purchase and electronically deliver redemption information to a second user with a single electronic communication made from a first user to the system is further disclosed. According to some embodiments, the single electronic communication may be selected from one or more of the group consisting of: an electronic mail communication, a mobile application task, a mobile messaging application communication, a short message service (SMS) communication, a multimedia message service (MMS) communication, a voicemail communication, an automated voice-enabled phone call communication, an automated key-enabled phone call communication, a voice-command to a mobile application, a voice-command to a vehicular navigation assistant, and a web-based submission. According to some embodiments, the redemption information may pertain to an item, product, good, or service. According to some embodiments, the redemption information may be pre-paid by the first user. According to some embodiments, the redemption information may be paid by the first user upon using the redemption information. According to some embodiments, the redemption information may pertain to an item code. According to some embodiments, the item code may comprise a vanity alpha-numeric code, or a UPC code. According to some embodiments, the item code may be selected from one or more of the group consisting of: a GTIN-8 code, a GTIN-12 code, a GTIN-13 code, a GTIN-14 code, a 6 “zero-suppressed” (UPC-E) code, a UPC-A code, a UPC-E code, an EAN-8 code, an EAN-13 code, a JAN code, and a GS1 barcode. According to some embodiments, the redemption information may comprise a single redemption code or machine-readable image for a plurality of pre-paid items, products, goods, or services. According to some embodiments, the item code may be provided to one or more of the group consisting of: a catalog, a brochure, a website, a mobile application, an online marketplace, a magazine, a newspaper, a radio broadcast, a movie theatre commercial, a television broadcast, an internet TV transmission, a billboard, a menu, a vehicle wrap, a sign, a display, a bumper sticker, and an advertisement.

According to some embodiments, a login page may comprise instructions to text a string containing one or more characters, numbers, letters, or combination thereof, to an electronic address; for example, using a mobile device [96]. According to some embodiments, the login page may comprise a web page.

Even further disclosed, is a method of logging into a website to access secure account features. According to some embodiments, the method may comprise the step of: providing instructions to text a string containing one or more characters, numbers, letters, or combination thereof, to a provided electronic address using a mobile device. According to some embodiments, the method may comprise the step of providing a field for entering and receiving a one-time PIN, password, pass code, alpha-numeric key, or passphrase. According to some embodiments, the method may comprise the step of delivering to the mobile device, a one-time PIN, password, pass code, alpha-numeric key, or passphrase; for example, when the instructions are followed. According to some embodiments, the method may comprise the step of granting access to the account associated with the mobile device; for example, when the respective one-time PIN, password, pass code, alpha-numeric key, or passphrase is entered into the field.

A method for allowing a first user to purchase and electronically deliver redemption information to a second user is also disclosed. According to some embodiments, the method may comprise the first user sending a single electronic communication to the system. According to some embodiments, the single electronic communication may be selected from one or more of the group consisting of: an electronic mail communication, a mobile application task, a mobile messaging application communication, a short message service (SMS) communication, a multimedia message service (MMS) communication, a voicemail communication, an automated voice-enabled phone call communication, an automated key-enabled phone call communication, a voice-command to a mobile application, a voice-command to a vehicular navigation assistant, and a web-based submission. According to some embodiments, the redemption information may pertain to an item, product, good, or service. According to some embodiments, the redemption information may be pre-paid by the first user. According to some embodiments, the redemption information may be paid by the first user upon using the redemption information. According to some embodiments, the redemption information may pertain to an item code. According to some embodiments, the item code may comprise a vanity alpha-numeric code, or a UPC code. According to some embodiments, the item code may be selected from one or more of the group consisting of: a GTIN-8 code, a GTIN-12 code, a GTIN-13 code, a GTIN-14 code, a 6 “zero-suppressed” (UPC-E) code, a UPC-A code, a UPC-E code, an EAN-8 code, an EAN-13 code, a JAN code, and a GS1 barcode. According to some embodiments, the redemption information may comprise a single redemption code or machine-readable image for a plurality of pre-paid items, products, goods, or services. According to some embodiments, the item code may be provided to one or more of the group consisting of: a catalog, a brochure, a website, a mobile application, an online marketplace, a magazine, a newspaper, a radio broadcast, a movie theatre commercial, a television broadcast, an internet TV transmission, a billboard, a menu, a vehicle wrap, a sign, a display, a bumper sticker, and an advertisement.

A checkout page is further disclosed. According to some embodiments, the checkout page may comprise a QR code, 1 dimensional barcode, 2 dimensional barcode, or other machine-readable indicia. According to some embodiments, the checkout page may comprise a web page. According to some embodiments, the checkout page may comprise a field for a one-time use PIN, password, pass code, alpha-numeric key, or passphrase to be entered. According to some embodiments, the one-time use PIN, password, pass code, alpha-numeric key, or passphrase may be delivered via one or more of the group consisting of: a system mobile application, an electronic mail communication, a mobile messaging application communication, a short message service (SMS) communication, and a multimedia messaging service (MMS) communication.

According to some embodiments, a checkout page may comprise at least one machine-generated string of characters, numbers, and/or letters. According to some embodiments, the checkout page may comprise instructions to text the at least one machine-generated string of characters, numbers, or letters to a provided electronic address to make a purchase. According to some embodiments, the electronic address may comprise one or more of the electronic addresses selected from the group consisting of: an email address, a short code, a long code, and a phone number. According to some embodiments, the electronic address may comprise a short code, a long code, or a phone number. According to some embodiments, the electronic address may also be machine-generated. According to some non-limiting embodiments, the machine-generated string of characters, numbers, or letters cannot be interpreted by a machine and is designed to be read and understood by a human in order to reduce ability for a user to run a script to login automatically. According to some non-limiting embodiments, both the machine-generated string of characters, numbers, or letters and the machine-generated electronic address cannot be interpreted by a machine and are designed to be read and understood by a human in order to reduce ability for a user to run a script to login automatically. According to some embodiments, the purchase may be made using funds available from a purchasable card.

An electronically deliverable coupon or voucher for an item, product, good, or service paid for by a first user and intended for a second user is further disclosed. According to some embodiments, the electronically deliverable coupon or voucher may comprise indicia. According to some embodiments, the indicia may comprise electronic address information about the first user and/or the second user. According to some embodiments, the electronic address information may be encrypted, coded, or otherwise scrambled according to a proprietary coding algorithm. According to some embodiments, the electronic address information may be configured to be decrypted, de-coded, or otherwise unscrambled according to a proprietary de-coding algorithm based on the coding algorithm. According to some embodiments, the electronically deliverable coupon or voucher may be configured to be delivered via short messaging service (SMS), multimedia messaging service (MMS), electronic mail (email), or phone/voicemail. According to some embodiments, the indicia may comprise a string of text; for example, a string of text which may comprise one or more characters, integers, or letters. According to some embodiments, the indicia may comprise machine-readable indicia. According to some embodiments, the machine-readable indicia may comprise one or more of the codes selected from the group consisting of: a 1D barcode, a 2D barcode, a data matrix code, and a QR code.

A method of validating an electronically deliverable coupon or voucher for an item, product, good, or service paid for by a first user and intended for a second user, which is redeemable at a participating redeeming entity is further disclosed. According to some embodiments, the method may comprise one or more of the following step: delivering the electronically deliverable coupon or voucher to the second user via short messaging service (SMS), multimedia messaging service (MMS), electronic mail (email), or phone/voicemail; wherein the electronically deliverable coupon or voucher may comprise second user information; wherein the second user information may comprise information selected from one or more of the group consisting of: a phone number, an email address, a semi-permanent PIN, a one-time use PIN, a semi-permanent pass code, a semi-permanent password, and a semi-permanent passphrase; the second user providing the electronically deliverable coupon or voucher to the participating redeeming entity; the participating redeeming entity extracting the second user information from the electronically deliverable coupon or voucher. According to some embodiments, the method may comprise the step of the participating redeeming entity requesting the extracted second user information from the second user upon redemption of the electronically deliverable coupon or voucher. According to some embodiments, the second user information may be encrypted, coded, or otherwise scrambled in the electronically deliverable coupon or voucher. According to some embodiments, the second user information may be decrypted, de-coded, or otherwise unscrambled by the participating redeeming entity. According to some embodiments, wherein proprietary system software or a system application may be utilized to perform decryption, decoding, or unscrambling of the second user information. According to some embodiments, the second user information may be embedded in machine-readable indicia. According to some embodiments, the second user information is embedded in human-readable text. According to some embodiments, the method may comprise the step of the second user providing the participating redeeming entity with the requested second user information to complete a transaction regarding the item, product, good, or service. According to some embodiments, the method may comprise the step of the participating redeeming entity confirming that the extracted second user information matches the requested second user information provided by the second user in response to the participating redeeming entity's request. According to some embodiments, the method may comprise the step of the participating redeeming entity providing the item, product, good, or service to the second user if the extracted second user information matches the requested second user information provided by the second user. According to some embodiments, the method may comprise the step of the participating redeeming entity filing a reimbursement claim with (e.g., intended for addressing to) at least one of the group consisting of: the system, corporate headquarters, the manufacturer or service provider of the item, product, good, or service, and a clearing house. According to some embodiments, the method may comprise the step of fully or partially reimbursing the participating redeeming entity for the item, product, good, or service provided to the second user in exchange for presentation of the electronically deliverable coupon or voucher. According to some embodiments, the second user information may be plainly provided for viewing by the participating redeeming entity. According to some embodiments, the second user information may comprise a phone number or an email address of the second user. According to some embodiments, the method may comprise the step of the participating redeeming entity sending a one-time use PIN, password, pass code, or passphrase to the phone number or email address. According to some embodiments, the method may comprise the step of the second user checking his/her phone or email to obtain the one-time use PIN, password, pass code, or passphrase delivered to the phone number or email address. According to some embodiments, the method may comprise the step of the second user providing the one-time use PIN, password, pass code, or passphrase to the participating redeeming entity to complete a transaction regarding the item, product, good, or service. According to some embodiments, the method may comprise the step of the participating entity texting, emailing, or calling a respective short code, long code, phone number, or email address, and providing the second user information with one or more other pieces of redemption information provided on the electronically deliverable coupon or voucher in order to: verify its validity, confirm redemption, and/or verify that the electronically deliverable coupon or voucher is being redeemed by the appropriate second user. According to some embodiments, the method may comprise the step of providing the participating redeeming entity using a mobile application on a mobile device, wherein the participating redeeming entity may enter the second user information with one or more other pieces of redemption information provided on the electronically deliverable coupon or voucher into respective fillable fields displayed on the mobile application, in order to: verify its validity, confirm redemption, and/or verify that the electronically deliverable coupon or voucher is being redeemed by the appropriate second user. According to some embodiments, the method may comprise the step of providing the participating redeeming entity with a mobile application on a mobile device, wherein the participating redeeming entity may scan or capture machine-readable indicia provided on the electronically deliverable coupon or voucher using the mobile application, in order to: verify its validity, confirm redemption, and/or verify that the electronically deliverable coupon or voucher is being redeemed by the appropriate second user. According to some embodiments, the method may comprise the step the mobile application providing to the participating redeeming entity, second user information which may be requested from the second user to verify its validity, confirm redemption, and/or verify that the electronically deliverable coupon or voucher is being redeemed by the appropriate second user.

A method of validating an electronically deliverable coupon or voucher for an item, product, good, or service paid for by a first user and intended for a second user, which is redeemable at a participating redeeming entity is further disclosed. According to some embodiments, the method may comprise one or more of the following steps: delivering the electronically deliverable coupon or voucher to the second user via short messaging service (SMS), multimedia messaging service (MMS), electronic mail (email), or phone/voicemail; wherein the electronically deliverable coupon or voucher may comprise redemption information which is stored in a database accessible by the participating redeeming entity; and/or the participating redeeming entity extracting the redemption information from the electronically deliverable coupon or voucher to process a transaction regarding the item, product, good, or service. According to some embodiments, the database may be located on the participating redeeming entity's server, network, or computer. According to some embodiments, the database may be located on a system server, network, or computer which may be accessed by the participating redeeming entity via an online portal, web-based participating redeeming entity account, or mobile application. According to some embodiments, the method may comprise the step of the participating redeeming entity comparing the redemption information with the database to check if the redemption information is within the database and a status of the redemption information. According to some embodiments, the method may comprise the participating redeeming entity determining whether to process or decline the transaction based upon the redemption information. According to some embodiments, the method may comprise the participating redeeming entity processing the transaction based upon the redemption information, and providing the item, product, good, or service to the second user. According to some embodiments, the method may comprise updating the database to reflect use of the redemption information, indicate that the transaction has been completed, and/or update a status of the redemption information.

A checkout page is further disclosed. According to some embodiments, the checkout page may comprise a web page. According to some embodiments, the checkout page may comprise a string of characters, numbers, and/or letters and instructions to text the string of characters, numbers, or letters to a provided electronic address to make a purchase using a separately purchasable pre-paid card. According to some embodiments, the electronic address may comprise one or more electronic address selected from the group consisting of: an email address, a short code, a long code, and a phone number. According to some embodiments, the string of characters, numbers, and/or letters may comprise a machine-generated order reference number. According to some embodiments, the one-time use PIN, password, pass code, alpha-numeric key, or passphrase is delivered via one or more of the group consisting of: a system mobile application, an electronic mail communication, a mobile messaging application communication, a short message service (SMS) communication, and a multimedia messaging service (MMS) communication; for example, upon texting the string of characters, numbers, or letters to the provided electronic address. According to some embodiments, the checkout page may comprise a fillable field, wherein the one-time use PIN, password, pass code, alpha-numeric key, or passphrase may be provided to the fillable field. According to some embodiments, the checkout page may comprise a submit button, wherein cart items associated with the order reference number are paid for using funds from the separately purchasable pre-paid card by pressing the submit button, after the one-time use PIN, password, pass code, alpha-numeric key, or passphrase is provided to the fillable field. According to some embodiments, the checkout page may comprise a fillable field which may accept a semi-permanent PIN, password, pass code, alpha-numeric key, or passphrase associated with the separately purchasable pre-paid card. According to some embodiments, the separately purchasable pre-paid card may be selected from one or more of the group consisting of: a credit card, a debit card, a gift card, a stored-value card, an electronic gift card, and a card affiliated with a bank account or large financial institution. According to some embodiments, the separately purchasable pre-paid card may be obtained for free by filling out an application for the separately purchasable pre-paid card, opening an account with a financial institution, or opening an account with a credit institution.

A system is further disclosed. According to some embodiments, the system may be configured for allowing a first user to purchase and electronically deliver redemption information to a second user with as little as a single electronic communication made by the first user to the system, wherein the system is configured to receive and interpret an image containing machine-readable indicia attached to the electronic communication. According to some embodiments, the single electronic communication may be selected from one or more of the group consisting of: an electronic mail communication, a mobile application task, a mobile messaging application communication, a multimedia message service (MMS) communication, and a web-based submission. According to some embodiments, the redemption information may pertain to an item, product, good, or service associated with the machine readable indicia. According to some embodiments, the machine readable indicia may comprise alpha-numeric character information. According to some embodiments, the alpha-numeric character information may be selected from one or more of the group consisting of: a GTIN-8 code, a GTIN-12 code, a GTIN-13 code, a GTIN-14 code, a 6 “zero-suppressed” (UPC-E) code, a UPC-A code, a UPC-E code, an EAN-8 code, an EAN-13 code, a JAN code, and a GS1 barcode. According to some embodiments, the redemption information may be pre-paid by the first user. According to some embodiments, the redemption information may be paid by the first user upon using the redemption information. According to some embodiments, the redemption information may comprise a single redemption code and/or machine-readable image for a plurality of pre-paid items, products, goods, or services. According to some embodiments, the redemption information may comprise multiple redemption codes and/or machine-readable image for a plurality of pre-paid items, products, goods, or services. According to some embodiments, the machine-readable indicia may comprise an item code provided to one of the group consisting of: a catalog, a brochure, a website, a mobile application, an online marketplace, a magazine, a newspaper, a radio broadcast, a movie theatre commercial, a television broadcast, an internet TV transmission, a billboard, a menu, a vehicle wrap, a sign, a display, a bumper sticker, and an advertisement. According to some embodiments, the machine-readable indicia may be provided to product packaging, a product label, a product tag, a product box, a product container, a product sticker, and/or to a product itself (i.e., directly on the product). According to some embodiments, the system claim may comprise scanning means. According to some embodiments, the scanning means may comprise one or more of the group consisting of: a laser 1D barcode scanner, a laser 1D barcode scanner, a QR code reader, a data matrix reader, image interpretation software, and various combinations thereof.

A method of purchasing and electronically delivering redemption information to a second user with as little as a single electronic communication made by a first user to a system is further disclosed. According to some embodiments, the method may comprise the first user sending an SMS, MMS, or electronic mail communication to an electronic address of the system, and the first user attaching an electronic address of the second user to the SMS, MMS, or electronic mail communication. According to some embodiments, the electronic address of the system may comprise an email address. According to some embodiments, the electronic address of the system may comprise a phone number. According to some embodiments, the phone number may comprise a mobile phone number. According to some embodiments, the electronic address of the system may comprise a short code. According to some embodiments, the electronic address of the system may comprise a long code. According to some embodiments, the electronic address of the second user may comprise one or more of the group consisting of: a mobile phone number, a mobile phone email address, and a web-based domain email address. According to some embodiments, the electronic address of the second user may comprise multiple electronic addresses of multiple second users. According to some embodiments, the step of attaching an electronic address of the second user to the SMS, MMS, or electronic mail communication may comprise attaching the electronic address of the second user to at least one of: a “TO” field, a “CC” field, a “SUBJECT” field, and a “BODY” field of the SMS, MMS, or electronic mail communication. According to some embodiments, the communication may comprise an SMS or MMS communication, and the step of attaching the electronic address of the second user may comprise attaching the electronic address of the second user to a “TO” field of the SMS or MMS communication. According to some embodiments, the communication may comprise an SMS or MMS communication, and the step of attaching the electronic address of the second user may comprise attaching the electronic address of the second user to a “BODY” field of the SMS or MMS communication. According to some embodiments, the communication may comprise an electronic mail communication, and the step of attaching the electronic address of the second user may comprise attaching the electronic address of the second user to a “BODY” field of the electronic mail communication. According to some embodiments, the communication may comprise an electronic mail communication, and the step of attaching the electronic address of the second user may comprise attaching the electronic address of the second user to a “TO” field of the electronic mail communication. According to some embodiments, the communication may comprise an electronic mail communication, and the step of attaching the electronic address of the second user may comprise attaching the electronic address of the second user to a “CC” field of the electronic mail communication. According to some embodiments, the communication may comprise an electronic mail communication, and the step of attaching the electronic address of the second user may comprise attaching the electronic address of the second user to a “SUBJECT” field of the electronic mail communication. According to some embodiments, the communication may comprise an electronic mail communication, and the step of attaching the electronic address of the second user may comprise the step of attaching the electronic address of the second user to a “BODY” field of the electronic mail communication.

An electronic commerce platform configured to allow a user to make a transaction in as little as a single short message service (SMS) or multimedia (MMS) communication is also disclosed. According to some embodiments, the communication may comprise an item code. According to some embodiments, the item code may be selected from one or more of the group consisting of: a vanity alphanumeric code, a numeric code, and a numeric code representative of a barcode associated with an item, product, good, or service. According to some embodiments, the communication may comprise an amount of funds or credits to be sent. According to some embodiments, the electronic commerce platform may be configured to create a new user account for the intended recipient upon receipt of the communication. According to some embodiments, the intended recipient may utilize the electronic commerce platform to immediately send funds or credits, or purchase items, products, goods, or services using the electronic commerce platform. According to some embodiments, the electronic commerce platform may comprise one or more of the social network aspects or social functions selected from the group consisting of: “liking” an item, recommending an item, spying on another user, and “friending” another user. According to some embodiments, the electronic commerce platform may be configured to send one or items and/or funds or credits to one or more recipients in a single system transaction communication. According to some embodiments, the electronic commerce platform may be configured to interpret a command to perform one or more of the respective functions selected from the group consisting of: providing a user balance, linking an email or other electronic address, showing a portable wish list of “liked” items, showing one or more redemptions associated with a user, checking the cost of an item, grouping contacts into a generic shorthand code to be used in a transaction communication, grouping contacts into a personalized shorthand code to be used in a transaction communication, “friending” another individual, re-gifting a redemption code, voiding a redemption code, and accepting a friend request from another user. According to some embodiments, the electronic commerce platform may be configured to allow a user to make a transaction in as little as a single electronic mail (email) communication. According to some embodiments, the communication may comprise an item code. According to some embodiments, the item code may be selected from one or more of the group consisting of: a vanity alphanumeric code, a numeric code, and a numeric code representative of a barcode associated with an item, product, good, or service. According to some embodiments, the communication may comprise an amount of funds or credits to be sent. According to some embodiments, the electronic commerce platform may be configured to create a new user account for the intended recipient upon receipt of the communication. According to some embodiments, the intended recipient may utilize the electronic commerce platform to immediately send funds or credits, or purchase items, products, goods, or services using the electronic commerce platform. According to some embodiments, the electronic commerce platform may comprise one or more of the social network aspects or functions selected from the group consisting of: liking an item; recommending an item; spying on another user; and “friending” another user. According to some embodiments, spying on another user may only be permitted if the another user is a friend of the spying user. According to some embodiments, the electronic commerce platform may be configured to send one or items and/or funds or credits to one or more recipients in a single system transaction communication. According to some embodiments, the one or more recipients may be provided to a Cc: field of an electronic mail (email) to a mail server of the electronic commerce platform. According to some embodiments, the electronic commerce platform may be configured to interpret a command to perform one or more of the respective functions selected from the group consisting of: providing a user balance; linking an email or other electronic address; showing a portable wish list of “liked” items; showing one or more redemptions associated with a user; checking the cost of an item; grouping contacts into a generic shorthand code to be used in a transaction communication; grouping contacts into a personalized shorthand code to be used in a transaction communication; “friending” another individual; re-gifting a redemption code; voiding a redemption code; and accepting a friend request from another user. According to some embodiments, the electronic commerce platform may be configured to allow a user to make a transaction in as little as a single form-fillable webpage, without necessarily needing to log in or provide personal information other than an electronic mail (email) address or mobile device number. According to some embodiments, the communication may comprise an item code. According to some embodiments, the item code may be selected from one or more of the group consisting of: a vanity alphanumeric code, a numeric code, and a numeric code representative of a barcode associated with an item, product, good, or service. According to some embodiments, the communication may comprise an amount of funds or credits to be sent. According to some embodiments, the electronic commerce platform may be configured to create a new user account for the intended recipient, upon receipt of the communication. According to some embodiments, the intended recipient may utilize the electronic commerce platform to immediately send funds or credits, or purchase items, products, goods, or services using the electronic commerce platform. According to some embodiments, the electronic commerce platform may comprise one or more social network aspects or functions selected from the group consisting of: “liking” a product, item, good, or service; recommending a product, item, good, or service; spying on another user; and “friending” another user. According to some embodiments, the electronic commerce platform may be configured to send one or items and/or funds or credits to one or more recipients in a single system transaction communication. According to some embodiments, the electronic commerce platform may be configured to interpret a command to perform one or more of the respective functions selected from the group consisting of: providing a user balance; linking an email or other electronic address; “liking” a product, item, good, or service; showing a portable wish list of “liked” items; showing one or more redemptions associated with a user; checking the cost of an item; grouping contacts into a generic shorthand code to be used in a transaction communication; grouping contacts into a personalized shorthand code to be used in a transaction communication; “friending” another individual; re-gifting a redemption code; voiding a redemption code; and accepting a friend request from another user.

Also disclosed, is an electronic commerce platform which may use one or more of the following means to complete a transaction between a first user and one or more second users: an SMS-based message, an MMS-based message, an electronic mail (email) message, a phone call, a web form submission, a social network post, a social network communication, and a mobile application submission. According to some embodiments, one, some, or each of the aforementioned means to complete a transaction between a first user and one or more second users may access the same system database information. According to some embodiments, upon executing one or more of the aforementioned methods to complete a transaction between a first user and one or more second users, the one or more second users may be automatically assigned credentials to use the electronic commerce platform.

An electronic commerce platform is further disclosed. According to some embodiments, the electronic commerce platform may be configured to allow a user to make a transaction in as little as a single phone call. According to some embodiments, the communication may comprise an item code. According to some embodiments, the item code may be selected from one or more of the group consisting of: a vanity alphanumeric code, a numeric code, and a numeric code representative of a barcode associated with an item, product, good, or service. According to some embodiments, the communication may comprise an amount of funds or credits to be sent. According to some embodiments, the electronic commerce platform may be configured to create a new user account for the intended recipient upon receipt of the communication. According to some embodiments, the intended recipient may utilize the electronic commerce platform to immediately send funds or credits, or purchase items, products, goods, or services using the electronic commerce platform. According to some embodiments, the method may comprise one or more of the social network aspects or social functions selected from the group consisting of: liking an item, recommending an item, spying on another user, and “friending” another user. According to some embodiments, the electronic commerce platform may be configured to send one or items and/or funds or credits to one or more recipients in a single system transaction communication. According to some embodiments, the electronic commerce platform may be configured to interpret a command to perform one or more of the respective functions selected from the group consisting of: providing a user balance, linking an email or other electronic address, showing a portable wish list of liked items, showing one or more redemptions associated with a user, checking the cost of an item, grouping contacts into a generic shorthand code to be used in a transaction communication, grouping contacts into a personalized shorthand code to be used in a transaction communication, “friending” another individual, re-gifting a redemption code, voiding a redemption code, and accepting a friend request from another user. Another electronic commerce platform is disclosed. According to some embodiments, the electronic commerce platform may be configured to allow a user to make a transaction in as little as a single social media-based communication or feed post. According to some embodiments, the communication or feed post may comprise an item code. According to some embodiments, the item code may be selected from one or more of the group consisting of: a vanity alphanumeric code, a numeric code, and a numeric code representative of a barcode associated with an item, product, good, or service. According to some embodiments, the communication or feed post may comprise an amount of funds or credits to be sent. According to some embodiments, the electronic commerce platform may be configured to create a new user account for the intended recipient upon receipt of the communication or feed post. According to some embodiments, the intended recipient may utilize the electronic commerce platform to immediately send funds or credits, or purchase items, products, goods, or services using the electronic commerce platform. According to some embodiments, the electronic commerce platform may comprise one or more social network aspects or social functions selected from one or more of the group consisting of: liking an item, recommending an item, spying on another user, and “friending” another user. According to some embodiments, the electronic commerce platform may be configured to send one or items and/or funds or credits to one or more recipients in a single system transaction communication or feed post. According to some embodiments, the one or more recipients may be provided as a recipient of, or mention in, a social media post. According to some embodiments, the one or items and/or funds or credits may be provided as a hashtag or text in a social media post. According to some embodiments, the social media post may be addressed to a system handle or address. According to some embodiments, the electronic commerce platform may parse information within the social media post and may use the information to access and/or manipulate system database information which is stored on a server external to a social media platform supporting the social media post. According to some embodiments, the electronic commerce platform may parse information within the social media post and uses the information to access and/or manipulate system database information which is stored on a server of the social media platform. According to some embodiments, the system may provide a communication to a recipient contained within the social media post. According to some embodiments, the communication may be selected from one or more of the group consisting of: a mobile messaging application message, an SMS-based text message, an MMS-based text message, an email, a phone call, and a social media post. According to some embodiments, the one or more recipients may be provided as a mobile device number in a social media post. According to some embodiments, the one or more recipients may be provided as an email address in a social media post. According to some embodiments, the electronic commerce platform may be configured to interpret a command to perform one or more of the respective functions selected from the group consisting of: providing a user balance, linking an email or other electronic address, showing a portable wish list of liked items, showing one or more redemptions associated with a user, checking the cost of an item, grouping contacts into a generic shorthand code to be used in a transaction communication, grouping contacts into a personalized shorthand code to be used in a transaction communication, “friending” another individual, re-gifting a redemption code, voiding a redemption code, and accepting a friend request from another user.

A method of funding an account is also disclosed. According to some embodiments, the method may comprise one or more of the following steps: approaching a point of sale; requesting an amount of credit to be purchased; providing an electronic address; paying for the requested amount of credit; and/or electronically associating the paid for requested amount of credit to the provided electronic address. According to some embodiments, the method may comprise the step of creating a new account and a new account balance in the amount of the paid for requested amount of credit, and tying it to the provided electronic address, if an account is not already associated with the provided electronic address. According to some embodiments, the method may comprise the step of adding the paid for requested amount of credit to an account balance which is associated with the electronic address. According to some embodiments, the method may comprise the step of electronically receiving a notification of delivery and/or receipt of the paid for requested amount of credit associated with the provided electronic address, wherein the notification is delivered to the provided electronic address. According to some embodiments, the method may comprise the step of instantly utilizing the purchased amount of credit by sending some or all of the purchased amount of credit to another electronic address using an electronic communication. According to some embodiments, the electronic communication may be sent from the provided electronic address, to a system electronic address. According to some embodiments, the electronic communication may comprise one or more of: an instruction, a recipient electronic address, a recipient physical address, a generic item code, a vanity item code, a barcode number, a SKU number, a trademark, a trade name, a description, and a one-time security code. According to some embodiments, the system electronic address may be on the same platform and/or may use the same protocol or protocols as the provided electronic address. According to some embodiments, the system electronic address may be on a different platform and/or may use a different protocol or protocols as the provided electronic address. According to some embodiments, the order and/or location of information provided within the electronic communication the order and/or location of information provided within the electronic communication may be used for system parsing algorithms to process one or more transaction requests associated with the electronic communication. According to some embodiments, the order and/or location of information provided within the electronic communication may be important for system parsing algorithms to process one or more transaction requests associated with the electronic communication. According to some embodiments, the order and/or location of information provided within the electronic communication may not be important, wherein robust parsing algorithms are utilized to process one or more transaction requests associated with the electronic communication. According to some embodiments, the method may comprise the step of instantly utilizing the paid for requested amount of credit by sending some or all of the paid for requested amount of credit to another electronic address. According to some embodiments, the step of sending some or all of the paid for requested amount of credit to another electronic address may comprise providing an amount of credit to give and the another electronic address in a communication to a system electronic address, from the provided electronic address. According to some embodiments, the method may comprise the step of instantly utilizing the paid for requested amount of credit by purchasing and sending an electronic or physical item to another electronic address. According to some embodiments, the method may comprise the step of purchasing and sending an electronic or physical item to another electronic address may comprise providing an item code, and at least one of a recipient electronic address and a recipient physical address, in a communication to a system electronic address, from the provided electronic address. According to some embodiments, the item code may comprise one or more of the following: a generic item code, a vanity item code, a barcode number, and a SKU number. According to some embodiments, the step of paying for the requested amount of credit may comprise paying with one or more of the following: cash, credit card, debit card, coupon, prepaid voucher, gift card, store credit, gift certificate, or cryptocurrency. According to some embodiments, the provided electronic address may comprise a mobile device number, and the step of electronically associating the amount of credit to the provided electronic address may comprise: an entity other than the entity requesting the amount of credit/providing the electronic address texting: 1) a decimal or float value representing the paid for requested amount of credit, and 2) the mobile device number, to a system electronic address, in a short message service (SMS) communication. According to some embodiments, the system electronic address may comprise a system long code, a system short code, or system email address. According to some embodiments, the provided electronic address may comprise an email address, and the step of electronically associating the amount of credit to the provided electronic address may comprise: an entity other than the entity requesting the amount of credit/providing the electronic address texting: 1) a decimal or float value representing the paid for requested amount of credit, and 2) the email address to a system electronic address, in a short message service (SMS) communication. According to some embodiments, the system electronic address may comprise a system long code, a system short code, or system email address. According to some embodiments, the provided electronic address may comprise a social media profile ID, and the step of electronically associating the amount of credit to the provided electronic address may comprise: an entity other than the entity requesting the amount of credit/providing the electronic address texting: 1) a decimal or float value representing the paid for requested amount of credit, and 2) the social media profile ID, to a system electronic address, in a short message service (SMS) communication. According to some embodiments, the system electronic address may comprise a system long code, a system short code, or system email address. According to some embodiments, the provided electronic address may comprise a mobile device number, and the step of electronically associating the amount of credit to the provided electronic address may comprise: an entity other than the entity requesting the amount of credit/providing the electronic address emailing: 1) a decimal or float value representing the paid for requested amount of credit, and 2) the mobile device number, to a system electronic address, in an electronic mail (email) communication. According to some embodiments, the system electronic address may comprise a system email address. According to some embodiments, the provided electronic address may comprise an email address, and the step of electronically associating the amount of credit to the provided electronic address may comprise: an entity other than the entity requesting the amount of credit/providing the electronic address emailing: 1) a decimal or float value representing the paid for requested amount of credit, and 2) the email address, to a system electronic address, in an electronic mail (email) communication. According to some embodiments, the system electronic address may comprise a system email address. According to some embodiments, the provided electronic address may comprise a social media profile ID, and the step of electronically associating the amount of credit to the provided electronic address may comprise: an entity other than the entity requesting the amount of credit/providing the electronic address emailing: 1) a decimal or float value representing the paid for requested amount of credit, and 2) the social media profile ID, to a system electronic address, in an electronic mail (email) communication. According to some embodiments, the system electronic address may comprise a system email address. According to some embodiments, the electronic address may comprise a mobile device number, and the step of electronically associating the amount of credit to the provided electronic address may comprise: an entity other than the entity requesting the amount of credit/providing the electronic address communicating, via a third party platform or protocol: 1) a decimal or float value representing the paid for requested amount of credit, and 2) the mobile device number, to a system electronic address, in a third party platform or protocol communication.

According to some embodiments, the system electronic address may comprise a third party platform or protocol address, and the third party platform or protocol may comprise a social media platform or protocol. According to some embodiments, the step of communicating, via a third party platform or protocol, may comprise one or more of the group consisting of: a social media post, a social media direct message, a publicly viewable social media communication, a social media private message, and a public web forum communication. According to some embodiments, the electronic address may comprise an email address, and the step of electronically associating the amount of credit to the provided electronic address may comprise: an entity other than the entity requesting the amount of credit/providing the electronic address communicating, via a third party platform or protocol: 1) a decimal or float value representing the paid for requested amount of credit, and 2) the email address, to a system electronic address, in a third party platform or protocol communication. According to some embodiments, the system electronic address may comprise a third party platform or protocol address, and the third party platform or protocol may comprise a social media platform or protocol. According to some embodiments, the step of communicating, via a third party platform or protocol, may comprise one or more of the group consisting of: a social media post, a social media direct message, a publicly viewable social media communication, a social media private message, and a public web forum communication. According to some embodiments, the electronic address may comprise a social media profile ID, and the step of electronically associating the amount of credit to the provided electronic address may comprise: an entity other than the entity requesting the amount of credit/providing the electronic address communicating, via a third party platform or protocol: 1) a decimal or float value representing the paid for requested amount of credit, and 2) the social media profile ID, to a system electronic address, in a third party platform or protocol communication. According to some embodiments, the system electronic address may comprise a third party platform or protocol address, and the third party platform or protocol may comprise a social media platform or protocol. According to some embodiments, the step of communicating, via a third party platform or protocol, may comprise one or more of the group consisting of: a social media post, a social media direct message, a publicly viewable social media communication, a social media private message, and a public web forum communication. According to some embodiments, the social media profile ID may be selected from one or more of the group consisting of: a handle, a screen name, a profile number, and a unique name.

A method of purchasing, gifting, or wishing for a purchasable product, item, good, or service displayed on an electronic commerce mobile platform or website is further disclosed. According to some embodiments, the method may comprise: engaging a widget, icon, logo, hyperlink, text, or the like displayed adjacent a displayed purchasable product, item, good, or service displayed on an electronic commerce mobile platform or website; displaying a field adjacent the purchasable product, item, good, or service displayed on an electronic commerce mobile platform or website, which is configured to receive a personal electronic address; displaying a prompt adjacent the field, which may communicate an instruction to provide a personal electronic address; providing a personal electronic address in the field; sending a communication to the personal electronic address provided in the field, the communication containing instructions on how to complete a transaction pertaining to the purchasable product, item, good, or service displayed on an electronic commerce mobile platform or website; and replying to the communication, from the personal electronic address to complete the transaction pertaining to the purchasable product, item, good, or service. According to some embodiments, the method may comprise the step of deducting an amount of credit from a balance associated with the personal electronic address, wherein the amount of credit deducted from the balance associated with the personal electronic address is consistent with a cost of the purchasable product, item, good, or service displayed on the electronic commerce mobile platform or website. According to some embodiments, the amount of credit deducted from the balance associated with the personal electronic address may include an estimated, calculated, or predetermined shipping cost associated with the purchasable product, item, good, or service displayed on the electronic commerce mobile platform or website. According to some embodiments, the method may comprise the step of displaying a second field adjacent the purchasable product, item, good, or service displayed on an electronic commerce mobile platform or website, which is configured to receive a recipient electronic address and/or physical “shipping” address. According to some embodiments, the method may comprise the step of displaying a prompt adjacent the second field, which may communicate an instruction to provide a recipient electronic address. According to some embodiments, the method may comprise the step of providing a recipient electronic address in the second field, wherein the recipient electronic address belongs to an entity which is different from an entity associated with the personal electronic address. According to some embodiments, the method may comprise the step of electronically sending redemption information to redeem the purchasable product, item, good, or service displayed on an electronic commerce mobile platform or website, to the recipient electronic address. According to some embodiments, the redemption information may be used to physically pick up the purchasable product, item, good, or service displayed on an electronic commerce mobile platform or website, from a brick-and-mortar facility. According to some embodiments, the method may comprise the step of checking to see if the recipient electronic address is associated with a physical “shipping” address. According to some embodiments, the method may comprise the step of physically delivering the purchasable product, item, good, or service displayed on an electronic commerce mobile platform or website, to the physical “shipping” address associated with the recipient electronic address. According to some embodiments, the method may comprise the step of sending a communication to the recipient electronic address prompting for physical “shipping” address information if no physical “shipping” address is associated with the recipient electronic address. According to some embodiments, the method may comprise the step of sending a communication to the personal electronic address prompting for physical “shipping” address information of the recipient electronic address if no physical “shipping” address is associated with the recipient electronic address. According to some embodiments, the method may comprise the step of displaying a third field adjacent the purchasable product, item, good, or service displayed on an electronic commerce mobile platform or website, which is configured to receive a recipient physical address and/or physical “shipping” address if no physical “shipping” address is associated with the recipient electronic address. According to some embodiments, the method may comprise the step of entering physical “shipping” address associated with the recipient electronic address, in the third field. According to some embodiments, the method may comprise the step of deducting an amount of credit from a balance associated with the personal electronic address, wherein the amount of credit deducted from the balance associated with the personal electronic address is consistent with a cost of the purchasable product, item, good, or service displayed on the electronic commerce mobile platform or website. According to some embodiments, the amount of credit deducted from the balance associated with the personal electronic address may include an estimated, calculated, or predetermined shipping cost associated with the purchasable product, item, good, or service displayed on the electronic commerce mobile platform or website. According to some embodiments, the step of sending a communication may comprise sending at least one electronic communication via at least one of the group consisting of: a phone call, a mobile messaging application message, an SMS or MMS-based text message, a mobile messaging platform, an email, and a social media platform or protocol.

Also disclosed, is a method of sending funds or credit, and/or redemption information which may be used to redeem a product, item, good, or service, to multiple recipients. According to some embodiments, the method may be configured to send funds, credits, and/or redemption information which may be used to redeem a product, item, good, or service, to multiple recipients, in a single electronic communication. According to some embodiments, the method may comprise one or more of the following steps: creating a vanity address to be associated with one or more electronic addresses associated with one or more individuals; providing the vanity address in a communication to a system; providing the one or more electronic addresses associated with one or more individuals in a communication to the system; and/or using the vanity address in a subsequent communication to the system in combination with at least one of: an amount of funds or credit to be sent, and an item code corresponding to an item, product, good, or service to be sent. According to some embodiments, the method may comprise the step of delivering the at least one of: an amount of funds or credit to be sent, and an item code corresponding to an item, product, good, or service to be sent, to each of the one or more electronic addresses associated with one or more individuals, which is associated with the vanity address provided in the subsequent communication. According to some embodiments, the step of providing the vanity address in a communication to a system and the step of providing the one or more electronic addresses associated with one or more individuals in a communication to the system, may be performed simultaneously in the same communication. According to some embodiments, any one or more of the communications to the system may comprise sending at least one electronic communication via at least one of the group consisting of: a phone call, a mobile messaging application message, an SMS or MMS-based text message, a mobile messaging platform, an email, a social media platform or protocol, and a web submission.

A method of linking multiple electronic addresses to a single vanity address, in a single electronic communication is also disclosed. According to some embodiments, the method may comprise: creating a vanity address to be associated with multiple electronic addresses associated with one or more individuals. According to some embodiments, the method may comprise the step of providing both the vanity address and the multiple electronic addresses associated with one or more individuals in a communication to a system. According to some embodiments, the method may comprise the step of delivering at least one of: an amount of funds or credit, and redemption information corresponding to an item, product, good, or service; to each of the multiple electronic addresses, via a subsequent communication to the system. According to some embodiments, the subsequent communication to the system may comprise the vanity address, and at least one of: an amount of funds or credit to be sent, and an item code corresponding to an item, product, good, or service to be sent. According to some embodiments, any one or more of the communications to the system may comprise sending at least one electronic communication via at least one of the group consisting of: a phone call, a mobile messaging application message, an SMS or MMS-based text message, a mobile messaging platform, an email, a social media platform or protocol, and a web submission.

A method of sending funds or credit during a phone call is also disclosed. According to some embodiment, the method may comprise one or more of the following steps: a first user providing at least one of an electronic address, item code, amount, or transaction code to a second user; and/or at least one of the first and second users making an electronic communication to a system, wherein the electronic communication may comprise the at least one of an electronic address, item code, or transaction code. According to some embodiments, the method may comprise the step of at least one of the first and second users receiving an electronic communication from the system; wherein the electronic communication from the system may comprise one or more of: transaction information, redemption information, and account balance information.

A method of advertising is further disclosed. According to some embodiments, the method may comprise one or more of the steps consisting of: providing an amount and/or item code associated with a product, item, good, or service, in a physical or electronic advertisement, and/or providing an electronic address in a physical or electronic advertisement; receiving the physical or electronic advertisement; making an electronic communication to a system, wherein the electronic communication may comprise at least one of the amount, item code, and electronic address; and delivering an electronic communication from the system. According to some embodiments, the electronic communication from the system may comprise one or more of the group consisting of: transaction information, redemption information, and account balance information.

A method of online checkout is also disclosed. According to some embodiments, a user may utilize a separate electronic platform, in order to complete a transaction through a first electronic platform. According to some embodiments, the method may comprise one or more of the following steps: I.) providing a checkout page; and/or II.) communicating one or more of the following to a system electronic address via an SMS messaging, MMS messaging, mobile messaging, email, automated phone call, or social media protocol: a unique transaction code provided on the checkout page; a unique validation code provided on the checkout page; a vendor electronic address provided on the checkout page; a total cost provided on the checkout page; and, a one-time code delivered by/from the system via SMS messaging, MMS messaging, mobile messaging, email, automated phone call, or social media protocol. According to some embodiments, the method may comprise one or more of the following steps: III.) providing one or more prompts or fields on the checkout page; and/or IV.) providing one or more of the following to the one or more prompts or fields on the checkout page: a user electronic address selected from one or more of the group consisting of: a mobile device number, a phone number, an email address, and a social media profile ID address; a system card number; a system PIN number; a one-time code delivered by/from the system via SMS messaging, MMS messaging, mobile messaging, email, automated phone call, or social media protocol; a unique transaction code delivered by/from the system via SMS messaging, MMS messaging, mobile messaging, email, automated phone call, or social media protocol; a unique validation code delivered by/from the system via SMS messaging, MMS messaging, mobile messaging, email, automated phone call, or social media protocol. According to some embodiments, the method may comprise the step of accepting and recording inputs provided to the one or more prompts or fields on the checkout page. According to some embodiments, the method may comprise the step of communicating inputs provided to the one or more prompts or fields on the checkout page to the system, via a system API, over a public or private network. According to some embodiments, the public or private network may be selected from one or more of the group consisting of: a satellite network, a cellular telecommunications network, a landline network, the Internet, a virtual private network (VPN), and a cloud-based network, without limitation. According to some embodiments, the method may comprise the step of the system communicating back to a user of the checkout page, via SMS messaging, MMS messaging, mobile messaging, email, automated phone call, or social media protocol: a unique transaction code; a unique validation code; a one-time code delivered by/from the system via SMS messaging, MMS messaging, mobile messaging, email, automated phone call, or social media protocol. According to some embodiments, the method may comprise the step of the user of the checkout page replying back to the system via SMS messaging, MMS messaging, mobile messaging, email, automated phone call, or social media protocol with one or more of the following: a system card number; a system PIN number; a unique transaction code; a unique validation code; a one-time code delivered by/from the system via SMS messaging, MMS messaging, mobile messaging, email, automated phone call, or social media protocol. According to some embodiments, the method may comprise the step of providing one or more prompts or fields on the checkout page; and, according to some embodiments, the method may comprise the step of the user of the checkout page providing one or more of the following to the one or more prompts or fields on the checkout page: a user electronic address selected from one or more of the group consisting of: a mobile device number, a phone number, an email address, and a social media profile ID address; a system card number; a system PIN number; a one-time code delivered by/from the system via SMS messaging, MMS messaging, mobile messaging, email, automated phone call, or social media protocol; a unique transaction code delivered by/from the system via SMS messaging, MMS messaging, mobile messaging, email, automated phone call, or social media protocol; and a unique validation code delivered by/from the system via SMS messaging, MMS messaging, mobile messaging, email, automated phone call, or social media protocol.

A method of online checkout is further disclosed. According to some embodiments, the method may comprise one or more of the following steps: I.) providing a checkout page which may comprise: a total cost; at least one of: a vendor electronic address, a vendor vanity address which is recognized by a system, and a provided vendor item code; one or more fields; and a submit button; II.) communicating the at least one of a vendor electronic address, vendor vanity address, and vendor item code to an electronic address of the system via SMS messaging, MMS messaging, mobile messaging, email, automated phone call, or social media protocol; III.) communicating the total cost to an electronic address of the system via SMS messaging, MMS messaging, mobile messaging, email, automated phone call, or social media protocol; IV.) the system creating a redemption code and/or redemption PIN, and associating an incoming electronic address which is used to make the communications described in steps II and III, with the redemption code and/or redemption PIN; V.) the system delivering the redemption code and/or redemption PIN to the electronic address which is used to make the communications described in steps II and III; VI.) receiving the redemption code and/or redemption PIN via SMS messaging, MMS messaging, mobile messaging, email, automated phone call, or social media protocol; VII.) providing the redemption code and/or redemption PIN in the one or more fields provided to the checkout page; and/or VIII.) pressing the submit button. According to some embodiments, the method may comprise the step of providing the electronic address which is used to make the communications described in steps II) and III) in the one or more fields provided on the checkout page. According to some embodiments, the method may comprise the step of the system deducting a system account balance associated with the electronic address which is used to make the communication(s) described in steps II) and III), by the total cost, upon receipt of the total cost and the at least one of a vendor electronic address, vendor vanity address, and vendor item code. According to some embodiments, the total cost and the at least one of a vendor electronic address, vendor vanity address, and vendor item code communicated to the system (e.g., described in steps II) and III)), may be provided in the same electronic communication.

Also disclosed, is a method of sending and distributing funds, credit, products, items, goods, and/or services between: a first electronic address selected from one or more of the group consisting of: a phone number, an email address, and a social media address; and a second electronic address selected from one or more of the group consisting of: a phone number, an email address, and a social media address; from a first electronic platform selected from one or more of the group consisting of: electronic mail, SMS messaging, MMS messaging, mobile messaging, phone call, website, and social media; to a second electronic platform selected from one or more of the group consisting of: electronic mail, SMS messaging, MMS messaging, mobile messaging, phone call, website, and social media; for example, using no more than two communications to a system via the first electronic platform; for example, using no more than 50 character inputs in the no more than two communications; for example, without providing any more information in the no more than two communications, than the second electronic address, and at least one of the group consisting of: an amount of credit to send; a Universal Product Code (UPC); and an item code which may be associated with one or more of the following: an entity, an item, a product, a good, a service, a price of an item, a price of a product, a price of a good, a price of a service. According to some embodiments, credit associated with the first electronic address may be utilized on any one or more of the first electronic platforms selected from the group consisting of: electronic mail, SMS messaging, MMS messaging, mobile messaging, phone call, website, and social media. According to some embodiments, if the second electronic address is not affiliated with the system, the system may generate an account, and may associate the generated account with both the second electronic address, and the at least one of the group consisting of: an amount of credit to send; a Universal Product Code (UPC); and an item code which may be associated with one or more of the following: an entity, an item, a product, a good, a service, a price of an item, a price of a product, a price of a good, a price of a service. According to some embodiments, the method may comprise the step of the system sending an electronic communication to the second electronic address with a notification. According to some embodiments, the notification may comprise an indication that an account has been created for them. According to some embodiments, the notification may comprise balance information pertaining to the amount of credit. According to some embodiments, the notification may comprise redemption information pertaining to the Universal Product Code (UPC), or the item code. According to some embodiments, the system may be configured to receive the no more than two communications to a system from each and/or any one or more of the first electronic platforms selected from the group consisting of: electronic mail, SMS messaging, MMS messaging, mobile messaging, phone call, website, and social media; wherein the system may be configured to deliver a communication to the second electronic address via each and any one or more of the second electronic platforms selected from the group consisting of: electronic mail, SMS messaging, MMS messaging, mobile messaging, phone call, website, and social media. According to some embodiments, the no more than two communications to a system may comprise a single communication to a system. According to some embodiments, no more than 45 character inputs in the no more than two communications may be made. According to some embodiments, no more than 40 character inputs in the no more than two communications may be made. According to some embodiments, no more than 35 character inputs in the no more than two communications may be made. According to some embodiments, no more than 30 character inputs in the no more than two communications may be made. According to some embodiments, no more than 25 character inputs in the no more than two communications may be made. According to some embodiments, no more than 20 character inputs in the no more than two communications may be made. According to some embodiments, no more than 15 character inputs in the no more than two communications may be made. According to some embodiments, no more than 13 character inputs in the no more than two communications may be made.

A widget placed adjacent an item, product, good, or service for sale on a web page of a website is also disclosed. According to some embodiments, the widget, upon operative engagement with a first user of the website associated with a first electronic address, displays a UPC code, or item code on the web page; wherein a second electronic address and the UPC code or item code may be subsequently be provided in an SMS message, MMS message, mobile message, email, phone call, social media post, or web submission to a system electronic address by the first user, in order to both: automatically deduct credit associated with the first electronic address, by an amount (e.g., cost) of the item, product, good, or service for sale, and send an electronic transmission to the second electronic address containing redemption information for redeeming the item, product, good, or service in exchange for the redemption information. According to some embodiments, the widget may display, upon operative engagement by the first user, the amount of the item, product, good, or service for sale.

According to yet further embodiments, a method of sending and distributing funds, credit, products, items, goods, and/or services between: a first electronic address selected from one or more of the group consisting of: a phone number, email address, and a social media address; and a second electronic address selected from one or more of the group consisting of: a phone number, email address, and a social media address; may be made from a first electronic platform selected from one or more of the group consisting of: electronic mail, SMS messaging, MMS messaging, mobile messaging, phone call, website, and social media; to a second electronic platform selected from one or more of the group consisting of: electronic mail, SMS messaging, MMS messaging, mobile messaging, phone call, website, and social media; for example, using no more than two communications to a system via the first electronic platform; for example, using no more than 50 character inputs in the no more than two communications; for example, without providing any more information in the no more than two communications, than the second electronic address, and at least one of the group consisting of: an amount of credit to send, a Universal Product Code (UPC), and an item code which is associated with: a) one or more of the following: an entity, an item, product, good, or service; and b) a price of the item, product, good, or service; wherein if the second electronic address is not yet recognized by the system, the system may send an electronic communication to the second electronic address with at least one notification; wherein the at least one notification may comprise an indication that an account has been created for them, and wherein the at least one notification may comprise at least one of an account number and a personal identification number (PIN). According to some embodiments, the at least one notification may comprise sending both an account number and a personal identification number (PIN). According to some embodiments, the at least one notification may comprise sending the account number in a separate communication from the personal identification number (PIN). According to some embodiments, at least one of the account number and personal identification number (PIN) may be encoded in a machine-readable image. According to some embodiments, the machine-readable image may comprise a 2-D barcode or a 1-D barcode. According to some embodiments, the machine-readable image may comprise a QR code. According to some embodiments, the account number and personal identification number (PIN) may be scrambled together in a proprietary fashion according to a system-proprietary protocol which uses an algorithm. According to some embodiments, the account number and personal identification number (PIN) may be scrambled together differently, for different second electronic addresses. According to some embodiments, the algorithm may be derived from a number of characters within the second electronic address. According to some embodiments, the algorithm may use a sequence of more than one characters contained within the second electronic address. According to some embodiments, the algorithm may use a predetermined number of characters from the second electronic address, according to a proprietary pattern of characters, to determine how the account number and personal identification number (PIN) are scrambled together. According to some embodiments, the 2-D machine readable image may be scanned at a point of sale terminal, and the point of sale terminal may prompt for entry of the personal identification number (PIN). According to some embodiments, the 2-D machine readable image may be scanned at a point of sale terminal, and the point of sale terminal may prompt for entry of a one-time security code. According to some embodiments, the one-time security code may be delivered to the second electronic address via SMS messaging or MMS messaging. According to some embodiments, the one-time security code may comprise alphanumeric characters. According to some embodiments, the one-time security code may comprise second machine-readable indicia. According to some embodiments, the method may comprise scanning the second machine-readable indicia at the point of sale terminal to complete a transaction. According to some embodiments, the method may comprise entering the alphanumeric characters at the point of sale terminal to complete a transaction. According to some embodiments, the method may comprise scanning the machine-readable indicia at the point of sale terminal to access a list of redemption information associated with the second electronic address. According to some embodiments, the point of sale terminal may compare the list of redemption information against a list of pending items, products, goods, or services to be purchased, to see if any of the pending items, products, goods, or services to be purchased are found within the list of redemption information. According to some embodiments, the method may comprise finding one or more matches between the list of pending items, products, goods, or services to be purchased and the list of redemption information. According to some embodiments, for each match, the following may occur: redemption information is voided for the respective pending item, product, good, or service to be purchased which is associated with the redemption information; a cost of the respective pending item, product, good, or service to be purchased which is associated with the redemption information is deducted from a total amount due. According to some embodiments, the method may comprise sending one or more communications to the second electronic address containing a notification of which redemption information was voided. According to some embodiments, the method may comprise sending one or more communications to the first electronic address containing a notification of which redemption information was voided. According to some embodiments, the method may comprise presenting the account number and personal identification number (PIN) at a point of sale terminal to access a list of redemption information associated with the account number and/or personal identification number (PIN). According to some embodiments, the method may comprise providing the account number to a point of sale terminal to access a list of redemption information associated with the account number, and presenting one or more portions of the second electronic address to the point of sale terminal. According to some embodiments, the method may comprise authenticating the account number by accessing a database, and comparing the one or more portions of the second electronic address provided to the point of sale terminal, with the account number provided to the point of sale terminal. According to some embodiments, if the account number is authenticated, redemption information contained within the list of redemption information, may be used to complete a transaction.

A widget placed adjacent an item, product, good, or service for sale on a web page of a website is also disclosed. According to some embodiments, the widget, upon operative engagement with a first user of the website associated with a first electronic address, may display a first field for entering a first user electronic address, a second field for entering a security code, a third field for entering a recipient electronic address, and a submit button; wherein when the first user electronic address is entered into the first field, a system may deliver a one-time verification code to the first user electronic address, which is to be entered into the second field; wherein the first user may enter the recipient electronic address in the third field, and press the submit button to complete the purchase and delivery of the item, product, good, or service for sale. According to some embodiments, upon pressing the submit button, the first user's account is automatically deducted an amount of credit associated with the first electronic address, which is reflective of the amount of the item, product, good, or service for sale, and wherein an electronic transmission is delivered to the second electronic address containing redemption information for redeeming the item, product, good, or service in exchange for the redemption information. According to some embodiments, a confirm button may be provided adjacent the first field. According to some embodiments, a human verification field may be provided to the pop-up to prompt for entry of a displayed random character string. According to some embodiments, the human verification field may be for receiving a CAPTCHA code. According to some embodiments, the first field for entering a first user electronic address, the second field for entering a security code, the third field for entering a recipient electronic address, and the submit button may be displayed in a pop-up window. According to some embodiments, the first field for entering a first user electronic address, the second field for entering a security code, the third field for entering a recipient electronic address, and the submit button may be displayed in a second web browser window. According to some embodiments, the first field for entering a first user electronic address, the second field for entering a security code, the third field for entering a recipient electronic address, and the submit button may be displayed on a system webpage. According to some embodiments, a system item code field may be displayed, and the item code field may be pre-populated upon the operative engagement with the widget.

A method of redeeming received pre-purchased items, products, goods, or services is also disclosed. According to some embodiments, the method may comprise: approaching a point of sale payment terminal with a number of items, products, goods, or services to be redeemed; providing a user electronic address to the payment terminal; providing a PIN to the payment terminal; authenticating the electronic address using the one-time PIN provided to the payment terminal, via software; identifying matches between the number of items, products, goods, or services to be redeemed, and redemption information associated with the user electronic address, via software; electronically communicating the matches to the payment terminal, via software; confirming actual redemption of the matches at the payment terminal, via software; and, voiding redemption information associated with the user electronic address, which corresponds to the matches, via software. According to some embodiments, the PIN may comprise a one-time PIN. According to some embodiments, the one-time PIN may be delivered electronically to the user upon the step of providing a user electronic address. According to some embodiments, the one-time PIN may be delivered electronically to the user via a mobile application. According to some embodiments, the one-time PIN may be delivered electronically to the user via SMS or MMS messaging protocols. According to some embodiments, the one-time PIN may be alphanumeric. According to some embodiments, the one-time PIN may be in the form of machine-readable indicia. According to some embodiments, the one-time PIN may be in the form of a signal. According to some embodiments, the signal may comprise a light or sound wave. According to some embodiments, the PIN may comprise a reusable PIN. According to some embodiments, the PIN may be delivered electronically to the payment terminal upon the step of providing a user electronic address. According to some embodiments, the PIN may be delivered electronically to the payment terminal via a mobile application. According to some embodiments, the PIN may be delivered electronically to the payment terminal via SMS or MMS messaging protocols. According to some embodiments, the PIN may be alphanumeric. According to some embodiments, the PIN may be in the form of machine-readable indicia. According to some embodiments, the PIN may be in the form of a signal. According to some embodiments, the signal may comprise a light or sound wave.

A further method of redeeming received pre-purchased items, products, goods, or services is disclosed. According to some embodiments, the method may comprise: approaching a point of sale payment terminal with a number of items, products, goods, or services to be redeemed; providing a card to the payment terminal; providing a PIN to the payment terminal; authenticating the card using the one-time PIN provided to the payment terminal, via software; identifying matches between the number of items, products, goods, or services to be redeemed, and redemption information associated with the card, via software; electronically communicating the matches to the payment terminal, via software; confirming actual redemption of the matches at the payment terminal, via software; and, voiding redemption information associated with the card, which corresponds to the matches, via software. According to some embodiments, the PIN may comprise a one-time PIN. According to some embodiments, the one-time PIN may be delivered electronically to the user upon the step of providing a card. According to some embodiments, the one-time PIN may be delivered electronically to the user via a mobile application. According to some embodiments, the one-time PIN may be delivered electronically to the user via SMS or MMS messaging protocols. According to some embodiments, the one-time PIN may be alphanumeric. According to some embodiments, the one-time PIN may be in the form of machine-readable indicia. According to some embodiments, the one-time PIN may be in the form of a signal. According to some embodiments, the signal may comprise a light or sound wave. According to some embodiments, the PIN may comprise a reusable PIN. According to some embodiments, the PIN may be delivered electronically to the payment terminal upon the step of providing a card. According to some embodiments, the PIN may be delivered electronically to the payment terminal via a mobile application. According to some embodiments, the PIN may be delivered electronically to the payment terminal via SMS or MMS messaging protocols. According to some embodiments, the PIN may be alphanumeric. According to some embodiments, the PIN may be in the form of machine-readable indicia. According to some embodiments, the PIN may be in the form of a signal. According to some embodiments, the signal may comprise a light or sound wave.

A method of redeeming received pre-purchased items, products, goods, or services is further disclosed. According to some embodiments, the method of redeeming received pre-purchased items, products, goods, or services may comprise: approaching a point of sale payment terminal with a number of items, products, goods, or services to be redeemed; providing a card to the payment terminal; authenticating the card, via software; identifying matches between the number of items, products, goods, or services to be redeemed, and redemption information associated with the card, via software; electronically communicating the matches to the payment terminal, via software; confirming actual redemption of the matches at the payment terminal, via software; and, voiding redemption information associated with the card, which corresponds to the matches, via software.

A method of redeeming received pre-purchased items, products, goods, or services is disclosed. According to some embodiments, the method may comprise one or more of the following steps: approaching a point of sale payment terminal with a number of items, products, goods, or services to be redeemed; providing a user electronic address to the payment terminal; communicating a one-time PIN to the electronic address, via software; providing the one-time PIN to the payment terminal; authenticating the electronic address using the one-time PIN provided to the payment terminal, via software; identifying matches between the number of items, products, goods, or services to be redeemed, and redemption information associated with the user electronic address, via software; electronically communicating the matches to the payment terminal, via software; confirming actual redemption of the matches at the payment terminal, via software; voiding redemption information associated with the user electronic address, which corresponds to the matches, via software; and/or crediting the payment terminal for a predetermined amount which is reflected of the number of items, products, goods, or services to be redeemed, via software.

A method of redeeming received pre-purchased items, products, goods, or services is also disclosed. According to some embodiments, the method may comprise: approaching a point of sale payment terminal with a number of items, products, goods, or services to be redeemed; providing a mobile device associated with an electronic address, to the payment terminal; communicating information between the mobile device and payment terminal, via software; authenticating the electronic address, based upon the information communicated between the mobile device and payment terminal, via software; identifying matches between the number of items, products, goods, or services to be redeemed, and redemption information associated with the user electronic address, via software; electronically communicating the matches to the payment terminal, via software; confirming actual redemption of the matches at the payment terminal, via software; voiding redemption information associated with the user electronic address, which corresponds to the matches, via software; and, crediting the payment terminal for a predetermined amount which is reflected of the number of items, products, goods, or services to be redeemed, via software. According to some embodiments, the step of communicating information between the mobile device and payment terminal may comprise displaying machine-readable indicia on the mobile device, and optically reading machine-readable indicia provided on the mobile device using reader means or scanning means provided to the payment terminal. According to some embodiments, the step of communicating information between the mobile device and payment terminal may comprise sending one or more electromagnetic signals between the mobile device and the payment terminal. According to some embodiments, the one or more electromagnetic signals may comprise a light wave. According to some embodiments, the light wave may be in the visible spectrum. According to some embodiments, the light wave may comprise a unique hue of color. According to some embodiments, the light wave may be in the invisible spectrum. According to some embodiments, the light wave may be infrared or ultraviolet. According to some embodiments, the one or more electromagnetic signals may comprise a sound wave. According to some embodiments, the one or more electromagnetic signals may comprise an NFC-compatible signal. According to some embodiments, the one or more electromagnetic signals may comprise one or more electromagnetic signals unique to the electronic address.

According to some embodiments, the machine-readable indicia may be reusable and unique to the electronic address. According to some embodiments, the machine-readable indicia may be generated by a mobile application and may comprise one-time machine-readable indicia which may be unique to the electronic address. According to some embodiments, the machine-readable indicia may be encrypted. According to some embodiments, the machine-readable indicia may be encrypted upon the step of providing a mobile device associated with an electronic address, to the payment terminal.

Where used herein, the term “page” may refer to a web page, a browser screen, or a display provided on an application, such as a mobile application or software provided on or otherwise downloaded to a digital electronic device comprising a CPU, without limitation. For example, a page may be provided on a digital display of a laptop, a mobile device, a television screen, a digital display, billboard, onboard vehicle system found in vehicles, or the like, without limitation. It should also be appreciated that where it is used herein, the term “item” may comprise one or more “products”, “goods”, and/or “services”, without limitation, and that reciprocally, a product, good, or service may be referring to an item. It should also be appreciated that where they are used herein, the terms “item”, “products”, “goods”, and “services” may be used interchangeably and/or informally, without limitation.

It should also be appreciated that where they are used herein, the terms “friend(s)”, “contact(s)”, “family”, “coworker(s)”, and “family members”, may be used interchangeably and/or may have been used interchangeably, without limitation. For example, one, some, or all of these terms may relate to a single individual (e.g., a friend who is also a coworker, or a family member who is also a contact and a friend, without limitation). Occasionally, these terms may relate to multiple individuals (e.g., a friend who is not a coworker, and a family member who is a coworker, without limitation). Accordingly, these terms may relate more generally to, for example, another individual, another party, another user, a different entity, someone else, a person other than a person who is performing a particular step or task, or a party other than the party who is performing a step or task, etc., without limitation.

Moreover where used herein, the terms “SMS messaging”, “MMS messaging”, “mobile messaging”, “instant messaging”, and various permutations (e.g., “-based protocol”, “message”, and the like), may be used interchangeably and/or may have been used interchangeably, without limitation. Accordingly, it is anticipated that while prototypes have been developed utilizing SMS and email protocols, embodiments may employ any text messaging protocol and/or any voice-recognition protocol which might be configured to convert speech to text or decipher speech into a digital format which can be communicated with one or more servers of the system, without limitation. For example, a digital format which may be suitable for employing system parsing algorithms, may be utilized, without limitation.

It should also be appreciated that where it is used herein, the term “method” may comprise any one or more of the steps, functions, routines, sub routines, processes, procedures, logic, outputs, and/or executions disclosed in this application, co-pending applications of this applications, and/or priority applications to which this application claims the benefit of, without limitation. It should also be appreciated that where used herein, the term “system” may comprise any one or more of the features, functions, units, articles, means, devices, apparatus, groupings of apparatus, tools, abilities, capabilities, or the like, which are disclosed in this application, co-pending applications of this applications, and/or priority applications to which this application claims the benefit of, without limitation. Moreover, it should also be appreciated that where it is used herein, the term “apparatus” may, comprise any one or more of the features, functions, units, articles, means, devices, groupings of devices, tools, abilities, capabilities, or the like, which may be related to other apparatus disclosed in this application, co-pending applications of this applications, and/or priority applications to which this application claims the benefit of, without limitation.

Accordingly, while the present specification, drawings, and claims may outline some preferred or specific embodiments of and/or best modes for practicing methods, systems, and apparatus (for example, specific combinations of steps and/or elements, specific arrangements of steps and/or elements, specific groupings of steps and/or elements, and/or specific ordering of steps and/or elements, without limitation), the “present invention” as a whole, should not be deemed or unduly held to construe only those outlined preferred embodiments and/or best modes which are expressly disclosed. In other words, the scope and/or spirit of the “present invention” should not be limited to any particular or exacting arrangement or configuration which is expressly disclosed, but rather, the scope may be defined in the appending claims and/or claims of continuing applications which relate to this disclosure.

Although they may not be expressly spelled out in the aforementioned summary, other features and advantages may be appreciated from the description, drawings, and/or claims found in this application and related applications—including priority applications.

### BRIEF DESCRIPTION OF THE DRAWINGS

The appended figures schematically illustrate and explain components of a system and method for distributing, receiving, and using funds or credits according to various non-limiting embodiments. It should be understood that figures found in prior applications (to which this disclosure claims the benefit of) may not be expressly shown in this application, but are incorporated by reference. In the figures,

FIG. 1 is a schematic illustration of a portion of a system for distributing, receiving, and using funds or credits according to some embodiments.

FIGS. 2-3b are illustrative examples of kiosk apparatus according to some non-limiting embodiments.

FIG. 4 illustrates examples of image data and/or methods of delivery thereof according to some non-limiting embodiments.

FIG. 5 suggests types of audio data according to some embodiments.

FIG. 6 suggests types of user data according to some embodiments.

FIG. 7 suggests types of purchase data according to some embodiments.

FIG. 8 suggests types of redemption data according to some embodiments.

FIG. 9 suggests types of information regarding funds or credits according to some embodiments.

FIG. 10 suggests card contents according to some embodiments.

FIG. 11 suggests some non-limiting examples of vendors/entities which may participate with the system for distributing, receiving, and using funds or credits according to some embodiments.

FIG. 12 depicts a general communication layout scheme for a system according to some embodiments.

FIG. 13 suggests additional card contents according to some embodiments.

FIG. 14 suggests components of kiosks according to some embodiments.

FIGS. 15-19 show one possible non-limiting manner in which a system according to some embodiments may be used.

FIG. 20 suggests a possible embodiment of a system website in accordance with certain embodiments.

FIGS. 21-26 suggest an application that may be used with the system according to some embodiments.

FIGS. 27-38 show illustrative representative screen shots of a kiosk according to certain non-limiting embodiments.

FIG. 39 shows some features which may be incorporated in kiosks according to certain embodiments.

FIG. 40-56 show certain illustrative examples of cards which may be produced by self-service kiosks according to certain embodiments, including personalized and more generic/traditional types.

FIG. 57 shows one particular non-limiting illustrative examples of a personalized lottery ticket which may be produced by a kiosk according to some embodiments.

FIG. 58 shows one particular non-limiting illustrative example of a “brand-specific” gift card which may be used at any vendor that subscribes to a system according to some embodiments.

FIG. 59 shows one particular non-limiting illustrative example of a pre-paid voucher gift card which may be used at any vendor that subscribes to a system according to some embodiments.

FIG. 60 shows another non-limiting illustrative example of a pre-paid voucher gift card which may comprise subscriber logos, brands, trademark, or trade dress indicia.

FIG. 61 shows a more detailed schematic of a system for distributing, receiving, and using funds or credits according to some embodiments, wherein a purchaser uses a system-integrated kiosk apparatus to purchase a card for another person.

FIG. 62 shows a more detailed schematic of a system for distributing, receiving, and using funds or credits according to some embodiments, wherein a purchaser uses a system-integrated website to purchase a card for another person.

FIG. 63a shows a more detailed schematic of a system for distributing, receiving, and using funds or credits according to some embodiments, wherein a subscriber to the system which may have a user profile and system account number may use a system-integrated website to browse recent purchases, recent gifts from other users of the system, digital coupons automatically applied to their account, rewards points, club card status (e.g., the number of punch card visits left before a discount may be provided or applied), and the like, without limitation.

FIG. 63b shows a more detailed schematic of a system for distributing, receiving, and using funds or credits according to some embodiments, wherein a subscriber to the system may use a system-integrated application on a mobile device to navigate vendor/entity premises to find a desired product, item, offering, promotion, or service, and/or a subscriber to the system carrying a system-issued card may be tracked on vendor/entity premises to assist vendors/entities in re-designing store layouts, as well as vendors/entities in learning customer shopping habits and/or patterns while on vendor/entity premises.

FIG. 64 is a representative screen shot of a user of the system website browsing his/her system profile web pages, in particular, grocery deals amongst many other possible types of products, offerings, and categories.

FIG. 65a is one particular non-limiting example of how system-integrated cards produced by kiosk apparatus may be used in a shopping sequence.

FIG. 65b is another particular non-limiting example of how system-integrated cards produced by kiosk apparatus may be used in a shopping sequence.

FIG. 66 illustrates one possible interaction between a mobile device and kiosk apparatus according to some embodiments, for example using audio means.

FIG. 67 illustrates one possible interaction between a mobile device and kiosk apparatus according to some embodiments, for example using image means.

FIG. 68 illustrates one possible method of interacting with camera/image capture means provided to kiosk apparatus of the system according to some embodiments.

FIGS. 69-74 suggest various non-limiting ways that the system may interact with a mobile device for security measures, product browsing, payment, receipt, and/or other interactions.

FIG. 75 suggests one possible configuration of a user profile for a user of the system according to some embodiments.

FIG. 76 shows one possible example of accounts information which might be associated with a system-supported or issued kiosk card according to some embodiments.

FIGS. 77a-77c show non-limiting exemplary examples of a system-integrated application, particularly for use on a user's mobile device which may be utilized for general navigation within a system-supported venue or location based on product or vendor/entity information.

FIG. 78 shows a non-limiting exemplary example of a system-integrated application, particularly for use on a user's mobile device which may be utilized for general navigation within a system-supported venue or location based on product or vendor/entity information associated with the user's electronic shopping list.

FIG. 79 shows an example of how system kiosks, a system card, and a system application network may be integrated with an indoor positioning system, active inventory management system, security system, and/or other systems of a vendor/entity according to certain non-limiting embodiments.

FIGS. 80-82 illustrate examples of user profile information and associated metrics which may be obtained according to some embodiments.

FIG. 83 suggests how a system user may locate information pertaining to a venue/entity or a particular good, service, or offering associated with a vendor or entity, for example using his/her electronic shopping list and/or a system-based application; and may further suggest how a vendor or entity may provide offers to a user when a user's physical location may be adjacent to the vendor or entity.

FIG. 84 suggests how a system user may locate information pertaining to a particular good, service, or offering associated with a vendor or entity, for example using his/her electronic shopping list and/or a system-based application; and may further suggest how advertising means may provide offers to a user when a user's physical location may be adjacent to a particular good, service, or offering.

FIG. 85 suggests how a system card or system application can allow a user to gain instant access to a particular venue/location or structure of a vendor/entity without involving secondary human interactions.

FIG. 86 suggests a non-limiting example of how components of the system may improve customer experiences, for instance, with relevant advertising based on the customer's physical location, or helping assist a user to navigate within a structure of a particular venue/location or structure of a particular vendor/entity.

FIG. 87 suggests a non-limiting example of how a user's intended location or current location may be used in conjunction with advertising means, system software, and integrated third party applications to influence (or otherwise improve or facilitate) a user's purchasing activities.

FIG. 88 suggests a non-limiting example of how a user's current physical location within a venue/location or within a structure of a vendor/entity may be utilized to better focus advertisements in real-time, at a critical time.

FIG. 89a suggests a method of conveniently selling a product, service, or offer through the system using remote deposit technology.

FIG. 89b suggests a step of using system-stored funds or credits to receive another form of funds or credits, while simultaneously providing the ability to communicate information to friends or relatives.

FIG. 89c suggests a step of using system-stored funds or credits to receive another form of funds or credits and adding the another form of funds or credits to the user's electronic shopping list, while also providing the ability to communicate information to friends or relatives.

FIG. 89d suggests a step of purchasing and sending a fund or credit, such as a redemption option, to another individual using the system.

FIG. 89e suggests a step of receiving a sent fund or credit, such as a redemption option, from another individual using the system, which may provide a way to instantaneously thank the sender (e.g., via the system app, SMS/MMS, or post to a third party application such as a web-based social network), send the sender a thank you gift through the system (e.g., a prepaid sandwich, or a chocolate bar).

FIG. 90a suggests a method of remotely receiving a gift using the system according to some embodiments; for example, a ticket which would otherwise be wasted.

FIG. 90b suggests a step of securely receiving redemption information and providing options regarding the time of redemption for security purposes.

FIG. 90c suggests a step of utilizing redemption information at the time of redemption, and receiving real-time advertisements such as advertisements which may pertain to offers which might only be valid for a narrow timeframe (e.g., “within the next 15 minutes”).

FIG. 91 suggests one embodiment of a security feature, such as authentication or authorization code provided to a surface of an article which may be dispensed by a system kiosk, such as a card, a paper-based article produced by a system kiosk, or a release paperbacked sticker, wherein the security feature may comprise multiple layers of ink and/or different types of inks which may be visible or invisible under certain light wavelengths.

FIG. 92 suggests scanning means provided to a kiosk which may be able to emit different wavelengths of light to read encoded information which may be visible under different wavelengths of light.

FIG. 93 suggests scanning means provided to a payment terminal at a vendor or selling entity, which may read encoded information which may be visible under different wavelengths of light.

FIG. 94 suggests possible ways, according to some non-limiting embodiments, that a browser may be configured to work with various components of the system, such as for the sending funds, credits, or redemption options to friends associated with a user profile.

FIG. 95 suggests possible ways, according to some non-limiting embodiments, that a browser may be configured to work with various components of the system, such as for the sending funds, credits, or redemption options to friends associated with a user profile, and/or using location data and/or favorable friend opinions from both system and/or third-party applications to facilitate purchasing decisions.

FIG. 96 further suggests possible ways, according to some non-limiting embodiments, that a browser may be configured to work with various components of the system, such as for the sending funds, credits, or redemption options to friends associated with a user profile.

FIG. 97 further suggests possible ways, according to some non-limiting embodiments, that a browser may be configured to work with various components of the system, such as for the sending funds, credits, or redemption options to friends associated with a user profile, and/or for highlighting certain redemption options or otherwise providing special prompts to a user while shopping, when the certain redemption options have a favorable opinion by a contact, friend, or relative of the user of the browser.

FIG. 98 shows a system database which may comprise information regarding multiple user profiles, wherein information relating to favorite and/or favorable opinions of particular goods or services may be stored, as well as historical transactions, and particular goods or services on a user's shopping list, for example, a universal wish list. Some or all redemption options favored by a friend of a user may be added to various shopping lists or carts of a user, for example, one or more friend gift lists which may be charged universally in a plurality of different manners.

FIG. 99 schematically illustrates how cards and digital wallets associated with user profiles may communicate with each other via the internet or other network using various components of the system, wherein users may pay for, exchange, trade, and send funds, credits, and/or redemption options. For example, a good or a service provided on a first user's wish list may be added to a second user's shopping list, or purchased by the second user via the second user, simplifying gift registry processes and expanding registries to span across a plurality of non-affiliated vendors and selling entities.

FIG. 100 shows yet another non-limiting embodiment of a browser, in particular, a third-party application browser, using favorable opinions of friends to assist a user in making selections of redemption options and improving shopping experiences. For example, a user has immediate and prominent access to sharing with friends, connecting with friends, adding redemption options to a friend's wish list, adding redemption options to one or more of a plurality of customized gift lists for friends, sending partial funds or credits to a friend, etc.

FIG. 101 shows yet another embodiment of utilizing a system-integrated application with a website of a vendor or selling entity to improve customer shopping experiences.

FIG. 102 suggests various ways users of the system may interact with friends, digital accounts, and shopping lists during everyday activities, without necessarily requiring much effort, for example, by sending a free sandwich or drink by simply scanning a disposable container, sending an item to a friend while shopping on a TV network using the system application, or tapping a system card to a display provided in a retail environment. A system application may also assist a user in receiving automatic coupons or information regarding other local vendors or locations in which the item may be purchased at and/or for what price.

FIG. 103 suggests one non-limiting alternative way to determine location data based on friend selections using a system application integrated with a vendor website.

FIG. 104 suggests one non-limiting way to sign into a third-party vendor website with no need of entry of credit card information, shipping address information, or hassle of signing up or creating an account with a particular vendor for a one-time purchase, since all payment data and receipt info may be sent in accordance with the user's system profile information and preferences.

FIG. 105 suggests a method of incorporating universal wish lists, shopping lists, and gifting lists by logging in or otherwise linking a system account with a participating vendor or entity.

FIG. 106 suggests a method of quickly and easily adding of providing a favorable opinion (e.g., to a third-party website), adding to a personal wish list, adding to another's wish list, sending partial or full funds or credits to purchase the item to a friend, adding to a shopping list, adding an item as a system favorite, and/or purchasing with minimal effort using system profile information and recipient user data already on file with the system.

FIG. 107 suggests different ways a system or third-party search engine may utilize metadata and transaction information, along with social media information to enhance shopping experiences.

FIG. 108 expands on FIG. 102 by showing possible ways for information associated with audio data to be communicated to users of system components, for example, to conveniently update system or third-party profile information (e.g., wish lists, favorites, “Likes”), send funds, send credits, send redemption options, and/or the like.

FIGS. 109-110 schematically illustrate a method and method steps which may be used in a system for distributing, receiving, and using funds or credits according to some embodiments; particularly, for activating a card and mobile device-supported account.

FIGS. 111-117 schematically illustrate one possible method and method steps, which may be used in a system for distributing, receiving, and using funds or credits according to some embodiments; particularly, using an activated card which may have funds thereon, and a mobile device-supported account, to send, transfer, or gift funds, credits, (or items) to another user.

FIG. 118 suggests types of non-limiting, non-exhaustive card indicia for system apparatus according to some embodiments.

FIG. 119 suggests one simplistic system network which may be utilized by the system, according to some embodiments.

FIGS. 120a-120b, and 120d-120e suggest a non-exhaustive example of a system database which may be utilized with components of the system for distributing, receiving, and using funds or credits according to some embodiments; particularly, for authenticating user instructions and for performing certain card transactions using a card and mobile device-supported account; according to some embodiments.

FIG. 120c suggests some types of profile information which may be associated with a system database according to some embodiments.

FIGS. 121 and 122 suggest some ways a user may send funds to another user according to some embodiments.

FIGS. 123 and 124 suggest some ways a user may request funds from another user according to some embodiments.

FIGS. 125 and 126 suggest some ways a user may send an item to another user according to some embodiments.

FIGS. 127 and 128 suggest some ways a user may buy an item for the user, or for another user (e.g., an individual who might utilize the recipient's mobile device number) according to some embodiments.

FIGS. 129 and 130 suggest some ways a user may like an item according to some embodiments.

FIGS. 131 and 132 suggest some ways a user may add an item to a personal wish list (shown), or to another user's wish list (e.g., an individual who might utilize the recipient's mobile device number) according to some embodiments.

FIGS. 133 and 134 suggest some ways a user may recommend an item to another individual (e.g., a phone contact, relative, or friend) according to some embodiments.

FIGS. 135 and 136 suggest yet other ways a user may send funds to another user according to some embodiments.

FIGS. 137 and 138 suggest yet other ways a user may send an item to another user according to some embodiments.

FIGS. 139 and 140 suggest yet other types of non-limiting, non-exhaustive card indicia for system apparatus according to some embodiments.

FIGS. 141a-142b suggest yet even further ways a user may send funds to another user according to some embodiments.

FIGS. 143a-144b suggest yet even further ways a user may send an item to another user according to some embodiments.

FIG. 145 suggests some possible ways to perform certain profile functions, commerce functions, etc. by texting a number or a word to a system-specified number (e.g., a “short code”) or by tapping a smart system card, or swiping a mobile device provided with a system application; wherein instructions may be provided visually (e.g., with image data).

FIG. 146 suggests some possible additional ways to perform certain profile functions, commerce functions, etc. by texting a number or a word to a system-specified number (e.g., a “short code”); wherein instructions may be provided audibly (e.g., with audio data).

FIG. 147 suggests one envisaged method of sending small fast food items to contacts, relatives, or friends, or otherwise “liking” the items, sharing the items, recommending the items, adding the items to a wish list, buying the items for additional subsequent use, providing favorable (and/or not favorable) opinions of the items, etc.

FIG. 148 suggests another embodiment of a method which may be configured for sending small fast food items to contacts, relatives, or friends, or otherwise “liking” the items, sharing the items, recommending the items, adding the items to a wish list, buying the items for additional subsequent use, providing favorable (and/or not favorable) opinions of the items, etc.

FIG. 149 suggests a way of updating profile information (e.g., a social network profile 131′ or a system profile 130) via a mobile device using voice command-enabled speech texting, or via an integrated hands-free vehicle voice command-enabled mobile calling/texting platform.

FIG. 150 suggests one type of vendor or selling entity which may, according to some embodiments, utilize system indicia to make a purchase without actually calling the vendor or selling entity, without needing to speak to a representative of the vendor or selling entity, without needing to log on to a website of the vendor or selling entity, and/or without needing to enter or give out bank or credit card information to the vendor or selling entity. In other words, as shown, a home shopping network or television-based advertisement may provide the system indicia, and a user may, with one single text, buy the item for themselves or for a contact, relative, or friend of the user with ease, or otherwise provide a favorable opinion, update a profile, recommend to friends, add to a wish list, add to a shopping list, etc.

FIG. 151 suggests one type of vendor or selling entity (e.g., online marketplace or website) which may, according to some embodiments, utilize system indicia to make a purchase without needing to call the vendor or selling entity, without needing to speak to a representative of the vendor or selling entity, without needing to log on to a website of the vendor or selling entity to checkout, and/or without needing to enter or give out bank or credit card information to the vendor or selling entity or keep such information on the vendor/entity servers. In other words, as shown, an online shopping network or internet-based advertisement may provide the system indicia, and a user may, with one single text, buy the item for themselves or for a contact, relative, or friend of the user with ease, or otherwise provide a favorable opinion, update a profile, recommend to friends, add to a wish list, add to a shopping list, etc.

FIGS. 152 and 153 suggest television advertisements according to some embodiments, which may utilize system indicia to allow viewers to make a purchase without needing to call the vendor or selling entity, without needing to speak to a representative of the vendor or selling entity, without needing to log on to a website of the vendor or selling entity to checkout, and/or without needing to enter or give out bank or credit card information to the vendor or selling entity or keep such information on the vendor/entity servers. In other words, as shown, a vendor's TV advertisement may provide the system indicia, and a user may, with one single text, buy the item or redemption option for themselves or for a contact, relative, or friend of the user with ease, or otherwise provide a favorable opinion, update a profile, recommend to friends, add to a wish list, add to a shopping list, etc.

FIGS. 154a-154f suggest one non-exhaustive, non-limiting example of a transaction as experienced by a first user according to some embodiments.

FIGS. 155a and 155b suggest one non-exhaustive, non-limiting example of a transaction as experienced by a second user according to some embodiments—e.g., in response to the transaction by a first user shown in FIGS. 154a-154f.

FIGS. 156a-159a suggest other methods of delivery to a second user from a first user-initiated transaction according to some embodiments.

FIGS. 160a-163a suggest yet further system interactions with a second user of the system according to some embodiments.

FIG. 160b suggests a step which may occur after the step shown in FIG. 160a according to some embodiments.

FIG. 161b suggests a step which may occur after the step shown in FIG. 161a according to some embodiments.

FIG. 164a suggests yet other types of non-limiting, non-exhaustive card indicia for system apparatus according to some embodiments.

FIGS. 164b-164d suggest non-limiting, non-exhaustive steps which may occur using the card shown in FIG. 164a.

FIG. 165 suggests one non-limiting, non-exhaustive way of sending a physical item to another user according to some embodiments, for example, the item shown in FIG. 151.

FIG. 166 suggests one way of sending an electronically-redeemable item to another user according to some embodiments, for example, a related item or other delivery method of the item to the one shown in FIG. 151.

FIG. 167 suggests one non-limiting, non-exhaustive way of sending an electronically redeemable item to another user according to some embodiments, for example, a related item or other delivery method of the item to the one shown in FIG. 150.

FIGS. 168a and 168b show a conventional store gift card of the prior art, for example, a gift card of Wal-Mari® brand stores.

FIGS. 169-171 show various store gift cards according to some non-limiting embodiments, for example, used in conjunction with gift cards of Wal-Mart® brand stores.

FIG. 172 suggests one non-limiting embodiment of a store gift card in accordance with some embodiments.

FIG. 173 suggests a non-limiting system for supporting the store gift card of FIGS. 169-172, according to some embodiments.

FIG. 174a suggests a first step of purchasing an item according to some embodiments, using the store gift card of FIGS. 169-172 and components of the system shown in FIG. 173.

FIG. 174b suggests a second step of receiving an item according to some embodiments.

FIG. 175 suggests a method of employing a number of small kiosks provided throughout portions of a brick-and-mortar retail facility which may allow a user to perform gifting functions while physically shopping.

FIG. 176 suggests a method of shopping online which may provide an opportunity to checkout via a mobile device, according to some embodiments.

FIG. 177 suggests a method of gifting a digital shopping list using a mobile application at a point-of-sale checkout terminal according to some embodiments.

FIG. 178 suggests a method of gifting a digital shopping list using a mobile application without needing to approach a point-of-sale checkout terminal according to some embodiments.

FIGS. 179a-179b suggest a non-limiting method of performing electronic commerce functions according to some embodiments, for example, using voice commands.

FIGS. 180a-180c suggest an alternative non-limiting method of performing electronic commerce functions according to some embodiments, for example, using voice commands.

FIGS. 181a-181c suggest yet another non-limiting method of performing electronic commerce functions according to some embodiments, for example, using voice commands.

FIGS. 182a-182h suggest yet even another non-limiting method of performing electronic commerce functions according to some embodiments, for example, using voice commands.

FIGS. 182i-182l suggest a further non-limiting method of performing electronic commerce functions according to some embodiments, wherein a recipient [91] of an electronic gift who happens to be watching a television commercial conveniently responds to a donor [91] of the electronic gift, with a thank-you electronic gift.

FIG. 183 suggests one possible non-limiting method of minimizing the number and or complexity of indicia, for example, standardizing user instructions, addresses, and functions related to the instructions by constraining or otherwise limiting, geographically, an area within which instructions may be validated and processed (e.g., a “time-out” zone); for example, by geographically spacing apparatus containing the instructions pertaining to different redemption options, and only validating instructions for a particular redemption option if a user's current physical location may be within a zone of proximity to the apparatus. In this regard, a similar instruction may be used or performed to perform similar functions for different items, products, goods, services, vendors, or selling entities.

FIG. 184 suggests a conventional method of generating new sales through the purchase and transfer of conventional gift cards, eGift certificates, pre-paid vouchers, etc.

FIG. 185 suggests benefits which may be provided by certain embodiments, namely, generating incremental sales and repeat customers through the wide distribution of token or small amount credits or low value pre-paid redemption options.

FIGS. 186 and 187 suggest non-limiting alternatives to utilizing SMS/MMS/mobile-messaging protocols to perform steps in accordance with some embodiments.

FIGS. 188-194 suggest various user-initiated interactions with a system-integrated mobile application according to certain embodiments; wherein FIGS. 190b-190e suggest non-limiting examples of recipient interactions.

FIG. 195 schematically illustrates a system and method for distributing, receiving, and using funds or credits according to some embodiments, wherein a checkout point of sale operator may facilitate delivery of funds or credits with user input.

FIGS. 196 and 197 suggest some exemplary, non-limiting examples of a receipt which may be provided after completing a transaction, according to some embodiments.

FIG. 198 schematically illustrates a system and method for distributing, receiving, and using funds or credits according to some embodiments, wherein a checkout point of sale terminal may be configured to facilitate delivery of funds or credits with user input.

FIG. 199 schematically illustrates a system and method for distributing, receiving, and using funds or credits according to some embodiments, wherein instructions may be provided and a user's mobile device may facilitate delivery of funds or credits using the instructions.

FIG. 200 schematically illustrates a system and method according to some embodiments, wherein instructions may be provided and a user's mobile device may facilitate sharing an opinion of an item, product, good, or service using the instructions.

FIG. 201 schematically illustrates a system and method according to some embodiments, wherein instructions may be provided and a user's mobile device may facilitate sharing an opinion of an item, product, good, or service using the instructions.

FIG. 202 schematically illustrates a system and method for distributing, receiving, and using funds or credits according to some embodiments, wherein instructions and/or machine-readable indicia may be provided and a user's mobile device may facilitate delivery of funds or credits using the instructions and/or machine-readable indicia.

FIG. 203 schematically illustrates a system and method according to some embodiments, wherein instructions and/or machine-readable indicia may be provided and a user's mobile device may facilitate delivery of recommendations of an item, product, good, or service using the instructions and/or machine-readable indicia.

FIGS. 204 and 205 suggest non-limiting examples of labels or tags which may comprise instructions and/or machine-readable instructions which may employed according to some embodiments.

FIG. 206 suggests a system and method for distributing, receiving, and using funds or credits according to some embodiments, wherein instructions and/or machine-readable instructions may be provided to an online marketplace and a mobile device may facilitate a function such as a purchase of an item, product, good, or service using the instructions and/or machine-readable indicia.

FIGS. 207 and 208 suggest systems and methods for distributing, receiving, and using funds or credits according to some embodiments, wherein instructions and/or machine-readable instructions may be provided to an online checkout page and wherein a mobile device may facilitate one or more functions such as a purchase of an item, product, good, or service using the instructions and/or machine-readable indicia.

FIG. 209 suggests a system and method for distributing, receiving, and using funds or credits according to some embodiments, wherein instructions and/or machine-readable instructions may be provided to an online checkout page and a mobile device may facilitate a function such as a purchase of an item, product, good, or service using the instructions and/or machine-readable indicia, wherein voice command software may optionally be provided to the user's mobile device, computer, website, browser, or plug-in.

FIG. 210 schematically illustrates a method of utilizing the instructions shown in FIG. 209 with a mobile device according to one non-limiting embodiment.

FIG. 211 schematically illustrates a method of utilizing the instructions shown in FIG. 209 with a mobile device according to another non-limiting embodiment.

FIGS. 212-213 show a method for distributing, receiving, and using funds or credits according to some embodiments.

FIG. 214 suggests components of one possible system according to certain embodiments.

FIGS. 215-216 show a method for distributing, receiving, and using funds or credits according to further embodiments.

FIGS. 217-221 show some non-limiting exemplary forms of machine-readable indicia which may be paired with indicia which may be suggestive of functions that will be performed when the machine-readable indicia is scanned using a system application.

FIG. 222 suggests a possible, non-limiting way of responding to a requesting user if recipient information may be invalid, or cannot be processed according to some embodiments.

FIG. 222A suggests a possible, non-limiting way of processing a request by a sending user according to some embodiments, without requiring security information.

FIG. 222B suggests a possible, non-limiting way of processing a request by a sending user according to some embodiments, requiring security information, such as a one-time PIN or pass code delivered to the sending user (according to some embodiments, security information may include certain card information such as a card number and/or PIN number, user account password, and/or portions thereof).

FIGS. 223-234 suggest various non-limiting ways of conveying requests to the system via email, according to some embodiments.

FIG. 235 suggests a non-limiting way to receive and process instructions to the system using different electronic addresses, such as different email addresses or domain extensions which may each pertain to a different function, according to some embodiments.

FIG. 236 suggests a non-limiting way to receive and process instructions to the system using different electronic addresses, such as different email addresses within a similar domain, wherein each email address may pertain to a different function, according to some embodiments.

FIG. 237 suggests a non-limiting way to receive and process instructions to the system via different short codes or long codes, according to some embodiments, wherein each short code or long code may pertain to a different function or participating entity, such as a vendor, service provider, manufacturer, retailer, or the like.

FIG. 238 suggests a non-limiting way to receive and process instructions to the system via a toll-free hotline and the selection of different prompts according to some embodiments (or voice-command), wherein each extension may pertain to different functions and may prompt different types of input from a user according to different algorithms.

FIG. 239 suggests a non-limiting way to receive and process instructions to the system via a single electronic address (such as an email address which may be stored to a user's contacts), wherein the user may provide various inputs or commands to the system to perform different functions.

FIG. 240 suggests a non-limiting way to receive and process instructions to the system via a single electronic address (such as a short code, long code, or phone number which may be stored to a user's contacts), wherein the user may provide various inputs or commands to the system to perform different functions.

FIG. 241 suggests a non-limiting embodiment of a system hotline main menu, according to some embodiments.

FIGS. 242-252 suggest various non-limiting examples of functionality of a system hotline main menu, according to some embodiments.

FIG. 253 suggests various articles, for example, a restaurant menu, which may incorporate item codes according to some embodiments.

FIG. 254 schematically suggests a non-limiting embodiment of a system website or system mobile application which may be displayed, for example, on a browser or screen of a mobile device or computing device.

FIG. 255 suggests one non-limiting example of a new account webpage or mobile webpage (and/or a screenshot from a mobile application), according to some embodiments.

FIG. 256 suggests one non-limiting example of a webpage or mobile webpage (and/or a screenshot from a mobile application), which may allow a user to add a contact, friend, or relative to their system account profile, for example, to facilitate phone-based transactions (e.g., wireless phone call, landline phone call, mobile messaging, or SMS/MMS messaging protocols), transactions made through the system website, and/or transactions made via email, according to some embodiments.

FIG. 257 suggests one non-limiting example of a detailed webpage or mobile webpage (and/or a screenshot from a mobile application), which may allow a user to send credit or an item to a contact, friend, or relative, according to some embodiments.

FIG. 258 suggests one non-limiting example of a user login webpage or mobile webpage (and/or a screenshot from a mobile application), which may allow a user to gain access to their system account profile without using phone or email, for example, to make transactions, link third party accounts, profiles, add friends, etc. Shown, are multiple methods of logging in which may be utilized alone or in combination with each other for added security.

FIGS. 259 and 260 visually depict a method of processing communications from users to facilitate transactions made using the system, according to some non-limiting embodiments.

FIG. 261 schematically illustrates one possible example of how the system may act as a clearing house service between individual vendors, corporate entities, and manufacturers/service providers, according to some non-limiting embodiments.

FIGS. 262 and 263 show exemplary, non-limiting examples of printable system-generated and/or delivered coupons (e.g., delivered to a recipient's email address), which may be utilized according to certain embodiments.

FIG. 264 suggests possible, non-limiting ways for system users to a make a transaction request to a system according to some embodiments.

FIG. 265 suggests a possible, non-limiting way for a system user to request a transaction, for example, the purchase and delivery of an item (e.g., a hair product) to a user having a mobile phone number (e.g., “7272779920” as shown) by sending an MMS message to the system containing an image of an item code (e.g., UPC bar code of the hair product), according to some embodiments; wherein security information may be attached to the communication to possibly eliminate the need for the system to send an authorization/confirmation message to confirm the sender's identity. The security information may be permanent, semi-permanent, or one-time use (e.g., a one-time PIN delivered by SMS message). For embodiments utilizing mobile messaging and/or a mobile application the security information may comprise encrypted communications link between the browser and a web server (e.g., using Secured Sockets Layer SSL, WAP server certificates, or other means for secure communication transmissions).

FIG. 266 suggests a possible, non-limiting way for a system user to request a transaction, for example, the purchase and delivery of an item (e.g., a hair product) to a user having a mobile phone number (e.g., “7272779920” as shown), for example, by sending an MMS message to the system containing an image of an item code (e.g., UPC bar code of the hair product), according to some embodiments; wherein security information may not be included in the communication; wherein the user may be prompted by a follow-up communication from the system (e.g., an SMS, MMS, or email request), to reply with a one-time use PIN, all or a portion of a system card number, all or a portion of a system card PIN number, or all or a portion of the user's semi-permanent changeable account password which may be set online, via: a mobile application, a phone call, SMS messaging, or MMS messaging (e.g., by following system instructions to provide the system with the semi-permanent changeable account password).

FIG. 267 suggests one non-limiting example of a communication which may be sent to a user of the system requesting a transaction to be made, in order to confirm the identity of the requesting party and ensure that the incoming phone number or phone email address of the user is correct and not a “spoof”. In the instant case, the message may request information pertaining to a pre-paid card that may be associated with the user's mobile device number which was used during activation. While not expressly shown, similar protocols may be used for requests received by email, and may contain information about the transaction (e.g., “You are about to . . . . Please confirm . . . ”).

FIG. 268 suggests one non-limiting example of a communication according to some embodiments, which may be sent to a user of the system requesting a transaction to be made, in order to confirm the identity of the requesting party and ensure that the incoming phone number or phone email address of the user is correct and not a “spoof”. In the instant case, the message may request a delivered one-time PIN to be included in a reply, along with instructions to be followed if information may be not correct or if the transaction may be fraudulent or otherwise compromised.

FIGS. 269 and 271 suggest non-limiting examples of transaction requests involving another party (e.g., a recipient of an item, product, good, or service to be sent), wherein the recipient information may be copied/Cc′d/attached in the “TO” field of the request communication, in order to notify the recipient(s) that a transaction involving them may be forthcoming, and/or to allow the system to identify recipient information, such as a 10-digit mobile phone number, a mobile phone email address, or other email address (e.g., such as a web-based or domain-based email address).

FIG. 270 suggests a possible non-limiting exemplary communication which may be sent to a requesting user to confirm a transaction and/or verify that the proper credit transfer amount, store credit, item, product, good, or service has been requested to the system, and to securely confirm the recipient's identity (e.g., to prevent misuse of the system by spoofing).

FIG. 272 suggests a possible, non-limiting exemplary embodiment of a system-generated MMS message which may be intended for one or more recipients, using system hardware and/or software. Such messages may be sent via a mobile device (e.g., cell phone, SMS gateway/auto-dialer, auto-responder, or other service or protocol utilized by mobile marketing agencies, mobile banking institutions, or the like).

FIG. 273 suggests a possible, non-limiting exemplary embodiment of a system-generated SMS message which may be intended for one or more recipients, using system hardware and/or software. Such messages may be sent via a mobile device (e.g., cell phone, SMS gateway/auto-dialer, auto-responder, or other service or protocol utilized by mobile marketing agencies, mobile banking institutions, or the like, and may contain redemption information, security information, instructions, or other information which may be necessary to redeem a credit transfer amount, store credit, item, product, good, or service which may have been pre-purchased by a sending/requesting user who initiated the transaction.

FIG. 274 suggests a possible manner to deliver redemption information to a recipient via MMS, for example, by sending a screen-displayable or printable image containing machine-readable indicia (e.g., 1D barcode, 2D barcode, data matrix code, QR code, or the like).

FIGS. 275 and 276 suggest a possible manner to deliver redemption information to a recipient via SMS, for example, by sending text containing information which may be necessary to redeem a credit transfer amount, store credit, item, product, good, or service which may have been pre-purchased by a sending/requesting user who initiated the transaction.

FIG. 277 suggests one possible, non-limiting way a user can purchase and gift an item by providing an item code to the system, according to some embodiments, wherein one or more recipient electronic addresses may be included in the “TO” field of an SMS, MMS, email, or other electronic communication, along with an electronic address of the system (e.g., a system short code, long code, phone number, email address, or the like).

FIG. 278 suggests a manner in which a user may submit an amount or item code to the system, and the system may reply with a list of functions or prompts to the user regarding various functions or options to be performed. The system may remove desired recipients from secure communications (e.g., prompting for user information such as system password/pass code, one-time SMS pass code information, system card account information, system card PIN number, or system card function code (as described in the co-pending applications listed at the beginning of this disclosure).

FIG. 279 suggests one possible non-limiting, exemplary embodiment of an incoming communication from a requesting user who has attached recipient information in the “TO” field of an MMS request message. The recipient information was added to the MMS request message to the system by selecting the contact from the user's mobile device “contacts” list stored on the user's smart phone.

FIG. 280 shows the incoming communication of FIG. 16 with the attachment partially opened. The image information may be exported to a display screen using a script and scanned automatically in an automated fashion with an appropriate scanner (e.g., laser barcode scanner, QR code reader, hybrid scanner, a plurality of scanners, or combinations thereof, as suggested in FIG. 19). In less preferred, but just as useful embodiments, the received information may be manually scanned (as suggested in FIG. 20) by one or more appropriate readers, or manually read to perform appropriate requested functions (e.g., “send1”, “request1”, “like1”, “redeem1”, “recommend1”, or the like). In the particular embodiment shown, the requesting user wishes to “send1” hair product (e.g., a 32 oz. Bottle of a selected type of TRESemme brand hair conditioner) to his/her friend/contact/relative “8016736751” stored in his/her mobile phone contacts list.

FIG. 281 shows an embodiment wherein multiple recipient 10-digit mobile phone numbers may be manually typed into, pasted into, or otherwise added to the body of the “send” transaction request communication, and wherein the system receives the communication, identifies the item from an attached image containing an item code, and identifies the requesting user's mobile number/email address to determine who to send a confirmation/one-time security PIN to, and/or who to deduct account credits from (in the shown example, the requester/purchaser of the gifted items is shown as “8015548634”).

FIGS. 282 and 283 schematically show how the system may be automated to scan incoming images containing product information. It is anticipated that sophisticated software may be used to automatically adjust contrasts, colors, sizes, sharpness, and other visual attributes of an incoming image, and determine the item code using software only (e.g., it may not be necessary to employ such external mounted or handheld scanners adjacent to display screens if image interpretation software is used to decode the image—e.g., to an 8, 12, 13, or 14 digit EAN, JAN, or UPC GTIN number).

FIG. 284 is one non-limiting example of a MySQL database table (e.g., “send1_cards”) containing a predetermined number of card numbers and associated card PINs, values, and status, which may be part of a system database of a system server, according to some embodiments. It should be understood that such a table could be broken into a plurality of numerous tables.

FIG. 285 is one non-limiting example of a MySQL database table (e.g., “send1_accounts”) which may contain a list of activated accounts and user information and which may be part of a system database of a system server, according to some embodiments.

FIG. 286 is one non-limiting example of a MySQL database table (e.g., “send1_{—}8015547238”) containing user account information such as an associated card/PIN information, account status, past transaction information, received redemption information, account balance information, user account passwords, user preferences, friend information, third party linked accounts information (e.g., Amazon.com, Yahoo, Google+, Facebook, Twitter), etc.; which may be part of a system database of a system server, according to some embodiments. It should be understood and appreciated by those of ordinary skill that statements intended for creating accounts, such as CREATE USER or GRANT may be utilized, and such statements may cause the server to make appropriate modifications to grant tables. The MySQL grant tables may be modified directly (e.g., manually) with statements such as INSERT, UPDATE, or DELETE.

FIG. 287 is one non-limiting embodiment of a web-based system platform which may be integrated with proprietary or third party SMS-enabled platforms or APIs (e.g., Twilio, Plivo, Quora, RingCentral, Speek, Phonebooth, Mightycall, Skype, AIM, tell.ly, CallRail, Nexmo, Tropo, TeIAPI, 46Elks, OneAPI4SMS.com, 3seventy.com). Designated long or short codes may be integrated with the system. Data formats used may include XML, JSON, Text, RSS, HTML, CSV, or other data format. Protocols used with system-integrated SMS APIs may include REST, SOAP, SMS, POST, XML-RPC, JAVASCRIPT, or other protocol. SMS confirmation protocols may be used to verify/authenticate a user's identity to make a transaction, access a user's account, and/or modify user system preferences.

FIG. 288 shows one non-limiting example of a first step of completing a system web-form according to some embodiments.

FIG. 289 shows one non-limiting example of a second step of running a system server-side script to populate one or more system database tables, perform functions, operations, manipulations to databases or database table information, etc., according to some embodiments.

FIGS. 290 and 291 show non-limiting examples of a third step of populating one or more system database tables according to some embodiments.

FIG. 292 shows a non-limiting example of a fourth step of accessing a database.

FIG. 293 shows a non-limiting example of a fifth step of providing a system user a confirmation (e.g., on a thank-you confirmation page) according to some embodiments.

FIG. 294 shows a non-limiting example of how users and participating entities alike can update preferences through a system account portal or preferences page or menu on a system website or application. Preferences, for example may be of the pull-down menu or tick box type for easy population of data into one or more database tables. In some embodiments, preferences may be sent via email to system customer service or faxed (via form), delivered via phone to customer service or automated hotline with prompted menu options and keypad input, snail mailed via postal service (e.g., in a letter or form format or contract/agreement), or received through SMS prompts (e.g., “text messaging”) to a user or participating merchant's mobile device.

FIG. 295 suggests one non-limiting embodiment of a system platform wherein users may trade in or cash out their redemptions or system credit for cash or store credit. The system may, per participating member agreements, reimburse the party who provides the cash or store credit. The party providing cash to a user in exchange for system credit may charge a percentile fee to provide the conversion services. In some embodiments, the system may receive payment from a party who converts system credit for store credit.

FIG. 296 suggests various non-limiting ways participating vendors, system merchants, service providers, retailers, and other organizations may handle leftover funds or credits from a redemption, according to some embodiments.

FIG. 297 suggests a non-limiting manner in which the system platform may be integrated with internet-based TV platforms, cable TV platforms, and/or other digital TV platforms (e.g., Comcast Xfinity, Verizon Fios, Google Play, Apple TV, Amazon Fire, etc), according to some embodiments. Such platforms may be through a gaming device (e.g., Microsoft Xbox, Nintendo Wii, Sony PlayStation, etc.). Voice commands or interactive menus may be indexed and manipulated via mobile application, remote buttons, gaming controller, or other controlling device.

FIG. 298 suggests a non-limiting manner in which the system platform may similarly be integrated with a phone, mobile device, or computing device, for example through a system-integrated application, according to some embodiments. The application may or may not be voice-enabled.

FIG. 299 suggests a non-limiting manner in which the system platform may similarly be integrated with a vehicular device, hardware, or application, such as an onboard computer, Bluetooth-enabled system, GPS, user interface, hands-free system, or the like, according to some embodiments. For example, applications like Apple SIRI may be integrated with system software to perform system functions, which may be preferably performed with minimal driver distraction (e.g., shop, gift, and give while driving, wherein the selections and options may be provided to signs, billboards (whether digital or static media), vehicle wraps, semi-truck trailers, bumper stickers, radio advertisements, radio broadcasts, radio programs, audio media (CDs, DVDs, previews), satellite radio, streaming/social media (e.g., YouTube, Netflix, Pandora, Facebook, Twitter), etc).

FIG. 300 suggests a non-limiting manner in which components, functions, operations, outputs, inputs, methods, steps, advantages, and the like of the system platform may be licensed to other parties, such as financial institutions or other entities, according to some embodiments. In such embodiments, members or potential members of the other parties (e.g., bank account holders, credit card applicants, and the like) may enjoy the ability to buy and gift items by mail, SMS, MMS, phone call, web-form, etc., as well as other benefits which may be exhibited through use of the system and various platform components thereof.

FIGS. 301-303 suggest some less preferred non-limiting manners in which components, functions, operations, outputs, inputs, methods, steps, advantages, and the like of the system platform may utilized, wherein separate system electronic addresses may be reserved for separate functions.

FIG. 304 suggests one non-limiting example of a MySQL database containing a predetermined number of tables (e.g., 6 as shown). Fewer or more tables may be present as features of the system might be added. It should be understood that the tables shown could be broken down into one or more additional tables or combined into fewer tables, without limitation.

FIG. 305 suggests one non-limiting example showing the tables within the MySQL database table shown in FIG. 304.

FIG. 306 is a continuation of FIG. 305.

FIG. 307 suggests one non-limiting embodiment of a table “users” within the database shown in FIGS. 304-306, showing column contents and respective types.

FIG. 308 shows one non-limiting example of a partially populated table “users” shown in FIG. 307; wherein the table shown may be populated using different platforms.

FIG. 309 is a continuation of FIG. 308.

FIG. 310 shows one non-limiting embodiment of a table “redemptions” which may be configured to store pre-purchased items, products, goods, or services according to some embodiments.

FIGS. 311 and 312 show a non-limiting example of the table “redemptions” of FIG. 310 being partially populated using different platforms.

FIG. 313 shows a non-limiting example of a table “likes” according to some embodiments.

FIG. 314 shows a non-limiting example of a partially-populated database table “likes” (as suggested in FIG. 313) using SMS-based system communications sent by a system user, according to some embodiments.

FIG. 315 shows a non-limiting example of a table “item” which may be used to store a number of system-integrated items which may be redeemed by users of the system and/or purchased by users of the system. The table may automatically grow (e.g., using Mysqli INSERT INTO) as users purchase new items, and participating vendors add new item codes. The vendor ID may be a unique code or simply the phone number or email address of corporate headquarters of the respective franchise, chain, or manufacturer of an item (shown, are headquarters corporate phone numbers).

FIG. 316 suggests one non-limiting embodiment of a partially-populated table “item” shown in FIG. 315. As shown, a short description, price (stored in integer format to reduce rounding errors), and item code may be entered. Descriptions may be added for 12-digit GTIN codes as shown. Ideally, participating entities would execute a system user agreement with system corporate executives, and as a condition, provide a list of items and associated item data (e.g., a free or unused ‘vanity’ item code, price, and account number).

FIG. 317 suggests one possible embodiment of a table “friendpending” where friend requests and (optional) generated one-time pin codes needed to complete the request may be stored.

FIG. 318 suggests one possible embodiment of a partially-populated “friendpending” table showing two past friend requests.

FIG. 319 suggests one possible embodiment of a “friend” table showing confirmed friend requests that were once in the “friendpending” table.

FIG. 320 suggests one possible embodiment of a partially-populated “friend” table.

FIG. 321 suggests a user inbox showing various incoming communications from the system on an electronic mail-based platform. As can be seen, redundancy may be built in, and recipient users may be copied in system transaction requests and receive both a sender's personal message with optional attachments, and a communication from the system. A one-time security key may be associated with each transaction, so the recipients can know that the redemption may be authentic. According to some embodiments, the security key may be added as a field in the table “redemptions” to address any potential customer service issues.

FIGS. 322-326 suggest a sample system web form page with SMS authentication means to confirm user identity. In the particular embodiment shown, no account login page may be required, but it is anticipated that as system features increase, users may wish to login and confirm identity once. In this regard, the system may be configured to allow a user to authenticate their identity once, and then allow the same user to enter a secure webpage and complete a number of transactions without necessarily performing the verification process again.

FIG. 327 suggests a sample confirmation page which may appear after a user completes the web form shown in FIGS. 322-326.

FIG. 328 is one non-limiting example showing an example email which may be received by a user after the user submits a request communication (e.g., via SMS, system application, or mobile messaging application, using a mobile device) asking to link an email address. In the non-limiting exemplary embodiment shown, the email may be received after the user texts “Link” followed by “an email address” which may be preferably their own to a system electronic address (e.g., a system long code, a system short code, or a system email address).

FIG. 329 suggests a non-limiting embodiment of a confirmation email relating to FIG. 328, wherein the user followed the directions provided in FIG. 328 and used one-time PIN information sent to the user by the system via a mobile platform (e.g., a SMS/MMS-based communication).

FIG. 330 is one non-limiting embodiment of a sent email-based request to the system by a user. The user sends, for example only, the number one (“1”) to a system email address to obtain a one-time security code which may be used to make a subsequent system request or complete a transaction using the system.

FIG. 331 shows one non-limiting example of an incoming email to a user after the system receives the email of FIG. 330.

FIG. 332 shows one non-limiting embodiment of an email that may be delivered to a sending user; for example, after a request to send a hamburger might be made to the system; wherein the user may have placed the recipient's email address in the Cc: field.

FIG. 333 shows one non-limiting embodiment of an email received by the recipient of a system transaction, according to some embodiments. In the particular embodiment shown, the recipient might know that the email may be legitimate, because he/she was originally copied (via Cc: field) of the initial email of the sender to the system requesting the transaction. The validation code shown “4KI8LS”, matches the earlier email, which may serve to further verify the validity of the redemption information.

FIG. 334 shows one non-limiting embodiment of an email that may be delivered to a sending user; for example, after a request for a one-time security code may be made to the system.

FIG. 335 shows a sent email wherein the sender pasted the one-time security code in the subject field, followed by an item or amount to be sent. The email was sent to a system address (e.g., ‘request@send1now.com’). The intended recipient's email address was placed in the Cc: field of the email. Accordingly, the intended recipient may receive the request email as well as the system. The sender, therefore, may optionally add a personal message, picture, note, or the like in the email (though this may not be shown in the figure).

FIG. 336 is an example of a confirmation email sent to a sending user.

FIG. 337 is an example of a redemption email sent to the intended recipient copied in the Cc: field of the request email (e.g., the one shown in FIG. 9). Note that the one-time security code may be attached, and therefore, the recipient may be able to readily verify the transaction is valid by matching the received one-time security code with the one received by the Cc′d request email sent directly from the sender. Further verification may be done by a quick note from the sender placed in the request email. For example, the sender may send the request email to the system with transaction information in the subject field of the email, and may include or otherwise add a message in the email body field before sending to the system and the recipient.

FIGS. 338 and 339 suggest a table “item” in a system database, which contains item codes. Each item code may, along with a vanity short code, barcode number, description, and/or price, may be associated with a keypad equivalent (for phone-based transactions and ordering). In this regard, a user may call a system number (e.g., a long code or phone number which may or may not be a local or toll-free number), and enter a recipient's phone number and then the item to be sent thereafter. For instance, “719563431378212” may be entered on the phone keypad when prompted, to send a $5 Footlong Subway brand sandwich to the mobile device having an electronic address of +1 (719) 563-4313. The number “7” corresponds to the letter “5”, the number “8” corresponds to the letter “U”, the number “2” corresponds to the letter “B”, and the numbers “1” and “2” corresponds naturally to the numbers “1” and “2” (e.g., representing a 12-inch foot long submarine sandwich rather than a 6-inch half submarine sandwich), Alternatively, separate prompts and entries may be used to prevent typos, but this may increase user time spent for the transaction. A call to the system may be terminated (e.g., by hanging up or ending the call) to cancel a transaction that may already be in progress. In this regard, any server-side scripts may terminate if the user failed to input correct information. It may be preferred, that this process be automated using speech-recognition software and an automated attendant software package/IVR. In such latter, non-illustrated embodiments, a user may call the system to make one or more system transactions hands-free while driving, rather than use proprietary speech-to-text or a intelligent personal assistant software which may already be installed on their own mobile device or vehicle's integrated dashboard/CPU/OS/head unit/navigational assistant. As can be seen in FIG. 339, a table “item” in a system database may contain a “keypadequiv” field which represents the numerical equivalent of an item code containing letters.

FIG. 340 suggests a table “users” in a system database which may contain third party electronic addresses, such as a Twitter handle. Alternatively, user IDs, screen names, or aliases from Facebook, Google+, LinkedIn, etc., may be stored in such a table for cross-platform integrations.

FIG. 341 suggests one non-limiting embodiment of an instruction which may be sent to the system via any commercial platform known in the art, for example, via a social media platform, email, SMS message, MMS message, phone call-based communication, or the like. The instruction may allow the requester to see a universal portable wish list of another user (or, in some embodiments, their own portable universal wish list). In some embodiments, only users who may be friends can be spied upon, though in some anticipated embodiments, wish lists may be made public to any person who provides the instruction to the system. Empty wish lists may be provided if the corresponding user associated with the mobile device number provided has not “liked” or “wished” for anything. Wish lists may be cut off, parsed, formatted, displayed, or trimmed in any fashion. For example, in some embodiments, only the most recent five “liked” items may be provided to a peeking requesting user.

FIG. 342 suggests one non-limiting embodiment of an instruction which may be sent to the system via any commercial platform known in the art, for example, via a social media platform, email, SMS message, MMS message, phone call-based communication, or the like. The instruction may allow a user to add an item to his or her own personal portable universal wish list. Script algorithms may be written robust enough to allow and still handle/process transactions despite some minor formatting errors as shown.

FIG. 343 suggests one non-limiting embodiment of an instruction which may be sent to the system via any commercial platform known in the art, for example, via a social media platform, email, SMS message, MMS message, phone call-based communication, or the like. The instruction may allow a user to “friend” or ask someone to be a “buddy” within the system.

FIG. 344 suggests one non-limiting embodiment of an instruction which may be sent to the system via any commercial platform known in the art, for example, via a social media platform, email, SMS message, MMS message, phone call-based communication, or the like. The instruction may allow a user to link his/her email address to his/her own system mobile account so that they can make transaction requests to the system via email using funds associated with their system mobile and/or social media profile accounts.

FIG. 345 suggests one non-limiting embodiment of an instruction which may be sent to the system via any commercial platform known in the art, for example, via a social media platform, email, SMS message, MMS message, phone call-based communication, or the like. The instruction may allow a user to link his/her social media profile, user ID, handle, extension, screen name, alias, or other electronic address to his/her own system mobile account, so that they can make transaction requests to the system via their social media profile to one or more of their social media friends using funds associated with their system mobile or email accounts. The particular embodiment shown suggests an SMS message that could be sent to the system from the user's mobile device, which may link their system funds to their “Twitter” account by providing an instruction to link their Twitter handle.

FIG. 346 suggests various methods in which social media communications (e.g., Twitter-based Tweets) could be made to perform various system functions through a third party platform (e.g., “Twitter”). In some non-limiting embodiments, API's or other art-recognized equivalent programming methods may be used to POST data which might be received by the system in the form of “Tweets”, via the system's Twitter feed, to the system's server, where database information may be accessed and/or manipulated as necessary. The system may then deliver redemption information directly (e.g., via direct message (DM) to the intended recipients) via Twitter. A primary recipient of a sending user's “Tweet” may be the intended recipient of system-delivered redemption information, funds, or credits. “Mentions” in any allowable number may be the intended recipient of system-delivered redemption information, funds, or credits. Items may be text-based and/or “hashtags”, and/or combinations thereof, without limitation. If a special hashtag associated with the system (e.g., #send1 or #send1 now) happens to be included in the communication, it may serve as a system “trigger” and the system may process the “Tweet” as a system request (albeit sent and received on the third party platform “Twitter”).

FIG. 347 suggests non-limiting ways in which a Twitter user may send each of his/her followers an item or amount of system credit. This could be used by wealthy individuals, celebrities, brand promoters, or corporations to promote their system. Redemptions may come in the form of text-based redemption codes and/or PINs, or may be scannable/machine-readable images like barcodes or QR codes which may be sent to the followers as a “Twitpic”. According to some embodiments, the system may provide custom redemption codes/images or promotional redemption codes/images to a system user to distribute in a predetermined or unlimited quantity, wherein the system user may be charged or sent an invoice by the system which reflects the number of actual redemptions made using the system.

FIGS. 348-350 indicate one of many anticipated embodiments envisaged, wherein a user may purchase system credit as if they were purchasing something at a store, online, or at a kiosk (e.g., an ATM).

FIGS. 351-355 suggest one manner of a system user purchasing an item and/or delivering it to his/her-self according to some embodiments.

FIGS. 356-360 suggest one manner of a system user purchasing a product, item, good, or service and/or delivering it for his/herself or for another according to some embodiments.

FIGS. 361-365 suggest one manner of a system user purchasing a product, item, good, or service and/or delivering it for his/herself or for another according to some embodiments.

FIGS. 366 and 367 suggest one manner of a system user performing one or more functions relating to a product, item, good, or service provided for sale (e.g., online).

FIGS. 368a-368b suggest one manner of a user gifting an item for sale “online” according to some embodiments.

FIGS. 369a-369b suggest one manner of a user gifting an item for sale “online” according to some embodiments.

FIGS. 370a-370f suggest one manner of a user gifting an item for sale “online” according to some embodiments.

FIGS. 371a-371c suggest one manner of a user gifting an item for sale “online” according to some embodiments.

FIGS. 372a-372c suggest one manner of a user gifting an item for sale “online” according to some embodiments.

FIGS. 373a-373c suggest one manner of a user gifting an item for sale “online” according to some embodiments.

FIGS. 374a-374b suggest one manner of a user wishing for an item for sale “online” according to some embodiments, wherein the wished item may be available for inspection by the public, or friends/family of the user wishing for the item.

FIGS. 375a-375b suggest one manner of a user wishing for an item for sale “online” according to some embodiments, wherein the wished item may be available for inspection by the public, or friends/family of the user wishing for the item.

FIGS. 376a-376b suggest one manner of a user wishing for an item for sale “online” according to some embodiments, wherein the wished item may be available for inspection by the public, or friends/family of the user wishing for the item.

FIGS. 377a-377b suggest one manner of a user wishing for an item for sale “online” according to some embodiments, wherein the wished item may be available for inspection by the public, or friends/family of the user wishing for the item.

FIGS. 378a-378d suggest one manner of a user wishing for an item for sale “online” according to some embodiments, wherein the wished item may be available for inspection by the public, or friends/family of the user wishing for the item.

FIGS. 379a-379b suggest one manner of a user purchasing an item for sale “online” according to some embodiments.

FIGS. 380a-380b suggest one manner of a user purchasing an item for sale “online” according to some embodiments.

FIGS. 381a-381b suggest one manner of a user purchasing an item for sale “online” according to some embodiments.

FIGS. 382a-382b suggest one manner of a user purchasing an item for sale “online” for another user according to some embodiments.

FIG. 383 suggests one manner of a user purchasing an item for sale “online” for another user according to some embodiments.

FIG. 384 suggests a method of ordering and purchasing a product, item, good, or service during a phone call between a first caller/orderer, and a second caller/order fulfillment entity, according to some embodiments, wherein a first caller/orderer may provide a phone number as his/her system electronic address, the second caller/order fulfillment entity may provide payment instructions to the system via a text message or phone call, the first caller/orderer may complete the transaction via a text message or phone call made to the system, and the second caller/order fulfillment entity may receive a receipt via a text message, phone call, or voicemail, from the system. It is anticipated that the second caller/order fulfillment entity may also provide the payment instructions to the system via text message, phone call, email, or other electronic platform, and the receipt may be delivered to the receiving caller/order fulfillment entity, from the system, via text message, phone call, email, or other electronic communications platform.

FIG. 385 suggests a method of ordering and purchasing a product, item, good, or service during a phone call between a first caller/orderer, and a second caller/order fulfillment entity, according to some embodiments, wherein a first caller/orderer may provide an email address as his/her system electronic address, the second caller/order fulfillment entity may provide payment instructions to the system via text message or phone call, the first caller/orderer may complete the transaction via an email to the system, and the second caller/order fulfillment entity may receive a receipt from the system, via a text message, phone call, or voicemail.

FIG. 386 suggests a method of ordering and purchasing a product, item, good, or service during a phone call between a first caller/orderer, and a second caller/order fulfillment entity, according to some embodiments, wherein the first caller/orderer may provide an email address as his/her system electronic address, the second caller/order fulfillment entity may provide payment instructions to the system via email, the first caller/orderer may complete the transaction via an email to the system, and the second caller/order fulfillment entity may receive a receipt from the system, via email.

FIG. 387 suggests a method of ordering and purchasing a product, item, good, or service during a phone call between a first caller/orderer, and a second caller/order fulfillment entity, according to some embodiments, wherein the first caller/orderer has a mobile device number (e.g., phone number) as his/her system electronic address, the first caller/orderer may provide information to the second caller/order fulfillment entity as necessary to complete the transaction, the second caller/order fulfillment entity may provide payment instructions which may comprise an item code or transaction code to the first caller/orderer, the first caller/orderer may complete the transaction via text messaging or a phone call to the system using the item code or transaction code provided by the second caller/order fulfillment entity, and the second caller/order fulfillment entity receives a receipt from the system via one or more of a number of different ways (e.g., email, payment terminal, social media post, system website profile/account, text messaging, phone call, or voicemail).

FIG. 388 suggests a method of ordering and purchasing a product, item, good, or service during a phone call, between a first caller/orderer, and a second caller/order fulfillment entity, according to some embodiments, wherein the first caller/orderer has a mobile device number as his/her system electronic address and optionally provides the second caller/order fulfillment entity with his/her system electronic address, the first caller/orderer may provide information to the second caller/order fulfillment entity as necessary to complete the transaction, the second caller/order fulfillment entity may provide an amount due to complete the transaction and an electronic address to send the funds to (e.g., a mobile device or phone number such as ‘3073452281’), instructions which may comprise the amount due and the electronic address to send the funds to may be sent from the first caller/orderer to the system via text messaging or phone call, and the second caller/order fulfillment entity may receive a receipt from the system via text messaging, phone call, or voicemail.

FIG. 389 suggests a method of ordering and purchasing a product, item, good, or service during a phone call, between a first caller/orderer, and a second caller/order fulfillment entity, according to some embodiments, wherein the first caller/orderer may have a mobile device number as his/her system electronic address and may provide the second caller/order fulfillment entity with his/her system electronic address, the second caller/order fulfillment entity generates a one-time transaction code and may provide it to the system with a total amount due and the first caller/orderer's provided electronic address via text message or phone call to the system, the first caller/orderer may complete the transaction via text messaging or a phone call to the system by replying to the system with the one-time transaction code provided by the second caller/order fulfillment entity (the one-time transaction code may also be provided to the first caller/orderer via the phone call, between the first caller/orderer and the second caller/order fulfillment entity), and the second caller/order fulfillment entity may receive a receipt from the system via one or more of a number of different ways (e.g., email, payment terminal, social media post, system website profile/account, text messaging, phone call, or voicemail). As shown, the receipt may be delivered to the second caller/order fulfillment entity via the same platform the instructions were sent, e.g., via text messaging, phone call, or voicemail.

FIG. 390 suggests a method of ordering and purchasing a product, item, good, or service during a phone call, between a first caller/orderer, and a second caller/order fulfillment entity, according to some embodiments, wherein the first caller/orderer has a mobile device number as his/her system electronic address and may provide the second caller/order fulfillment entity with his/her system electronic address, the second caller/order fulfillment entity may generate a one-time transaction code and may provide it to the system with a total amount due and the first caller/orderer's provided electronic address via an email to the system (other methods of delivering the instructions such as via payment terminal, social media post, system website profile/account, text messaging, phone call, or voicemail may alternatively be used), the first caller/orderer may complete the transaction via text messaging or a phone call to the system by replying to the system with the one-time transaction code provided by the second caller/order fulfillment entity (the one-time transaction code may also be provided to the first caller/orderer via the phone call, between the first caller/orderer and the second caller/order fulfillment entity), and the second caller/order fulfillment entity may receive a receipt from the system via one or more of a number of different ways (e.g., email, payment terminal, social media post, system website profile/account, text messaging, phone call, or voicemail). As shown, the receipt may be delivered to the second caller/order fulfillment entity via the same platform the instructions were sent, e.g., via email.

FIG. 391 suggests a method of ordering and purchasing a product, item, good, or service during a phone call, between a first caller/orderer, and a second caller/order fulfillment entity, according to some embodiments, wherein the first caller/orderer has an email address as his/her system electronic address and may provide the second caller/order fulfillment entity with his/her system electronic address, the second caller/order fulfillment entity generates a one-time transaction code and may provide it to the system with a total amount due and the first caller/orderer's provided electronic address via an email to the system (other methods of delivering the instructions such as via payment terminal, social media post, system website profile/account, text messaging, phone call, or voicemail may alternatively be used), the first caller/orderer may complete the transaction via an email to the system by replying to the system with the one-time transaction code provided by the second caller/order fulfillment entity in the email (the one-time transaction code may also be provided to the first caller/orderer via the phone call, between the first caller/orderer and the second caller/order fulfillment entity), and the second caller/order fulfillment entity may receive a receipt from the system via one or more of a number of different ways (e.g., email, payment terminal, social media post, system website profile/account, text messaging, phone call, or voicemail). As shown, the receipt may be delivered to the second caller/order fulfillment entity via the same platform the instructions were sent, e.g., via email. It should be understood that instead of an email address, the first caller/orderer may provide a social media profile ID (e.g., Twitter handle “@jsmith”), and may reply to the system with a “Tweet” containing the one-time transaction code, rather than an email to the system.

FIGS. 392-398 suggest various methods of ordering and purchasing a product, item, good, or service through email, parcel post, or electronic advertisement (radio, television, internet, broadcast, live/in-person advertisement, or the like), according to some embodiments, wherein a second user may obtain a system item code from the system and may include it with an email, parcel post, or electronic advertisement (radio, television, internet, broadcast, live/in-person advertisement, or the like), the email, parcel post, or electronic advertisement (radio, television, internet, broadcast, live/in-person advertisement, or the like) may be received by a first user, the first user may send a communication to the system which contains the system item code, the system may deduct the first user's system account balance by an amount equivalent to a product, item, good, or service associated with the item code, the system may provide redemption information to the first user, and the system may provide a receipt to the second user indicating that funds were obtained from the first user for the item code and/or that the second user's account has been credited by the amount.

FIG. 392 suggests that the communication from the first user to the system may be sent via email, social media post, or web submission, and that the receipt may be sent from the system to the second user via email, payment terminal, social media post, or to the second user's system account which may be viewable on a system website (e.g., viewable on a system website after receiving and validating the second user's login credentials and/or after a one-time authentication/validation code or 2-step authentication code may be sent to the second user and subsequently submitted through a system website field prompting for entry of the sent one-time authentication/validation code or 2-step authentication code).

FIG. 393 suggests that the communication from the first user to the system may be sent via email, social media post, or web submission, and that the receipt may be sent from the system to the second user via one or more text messages, phone calls, or voicemails.

FIG. 394 suggests that the communication from the first user to the system may be sent via one or more text messages or phone calls, and that the receipt may be sent from the system to the second user via one or more text messages, phone calls, or voicemails.

FIG. 395 suggests that the communication from the first user to the system may be sent via one or more text messages or phone calls, and that the receipt may be sent from the system to the second user via email, payment terminal, social media post, or to the second user's system account which may be viewable on a system website (e.g., viewable on a system website after receiving and validating the second user's login credentials and/or after a one-time authentication/validation code or 2-step authentication code may be sent to the second user and subsequently submitted through a system website field prompting for entry of the sent one-time authentication/validation code or 2-step authentication code).

FIG. 396 suggests that the communication from the first user to the system may be sent via a phone call, and that the receipt may be sent from the system to the second user via one or more text messages, phone calls, or voicemails.

FIG. 397 suggests that the communication from the first user to the system may be sent via a phone call, and that the receipt may be sent from the system to the second user via email, payment terminal, social media post, or to the second user's system account which may be viewable on a system website (e.g., viewable on a system website after receiving and validating the second user's login credentials and/or after a one-time authentication/validation code or 2-step authentication code may be sent to the second user and subsequently submitted through a system website field prompting for entry of the sent one-time authentication/validation code or 2-step authentication code).

FIG. 398 suggests that the communication from the first user to the system may be sent via email, payment terminal, social media post, or from the first user's system account which may be viewable on a system website (e.g., viewable on a system website after receiving and validating the first user's login credentials and/or after a one-time authentication/validation code or 2-step authentication code may be sent to the first user and subsequently submitted through a system website field prompting for entry of the sent one-time authentication/validation code or 2-step authentication code), and that the receipt may be sent from the system to the second user via email, payment terminal, social media post, or to the second user's system account which may be viewable on a system website (e.g., viewable on a system website after receiving and validating the second user's login credentials and/or after a one-time authentication/validation code or 2-step authentication code may be sent to the second user and subsequently submitted through a system website field prompting for entry of the sent one-time authentication/validation code or 2-step authentication code).

FIG. 399 suggests one non-limiting way in which a user may link one or more of his/her own electronic addresses to a single system vanity address to make it easier for other users to send the user funds, credits, items, products, goods, or services to the user, wherein an instruction to link the one or more of his/her electronic addresses to a single system vanity address may be delivered to the system via an electronic communication to the system, according to some embodiments. The communication to the system may be sent via email, text messaging, phone call, social media post, or from the user's system account which may be viewable on a system website, without limitation. The communication may contain the user's desired vanity address and/or the user's respective electronic addresses which are to be associated with (e.g., “linked to”) the user's desired vanity address.

FIG. 400 schematically suggests exemplary, non-limiting ways in which the communication to the system described in FIG. 399 may be sent to the system, and the system may validate and perform the requested linking function according to some embodiments, wherein the communication to the system may be made via text messaging or phone call, (e.g., SMS protocol, mobile messenger application, or the like).

FIG. 401 schematically suggests exemplary, non-limiting ways in which the communication to the system described in FIG. 399 may be sent to the system, and the system may validate and perform the requested linking function according to some embodiments, wherein the communication to the system may be made via email.

FIG. 402 schematically suggests exemplary, non-limiting ways in which the communication to the system described in FIG. 399 may be sent to the system, and the system may validate and perform the requested linking function according to some embodiments, wherein the communication to the system may be made via a third party social media platform (e.g., mobile application, messaging service, or website).

FIG. 403 schematically suggests exemplary, non-limiting syntax which could be contained within the communication to the system described in FIG. 399, according to some embodiments.

FIG. 404 suggests one non-limiting way in which a user may link one or more electronic addresses of his/her friends, relatives, contacts, co-workers, or the like, to a single system vanity address to make it easier for the user to send them funds, credits, items, products, goods, or services simultaneously, using the system, wherein an instruction to link the one or more electronic addresses to a single system vanity address may be delivered to the system via an electronic communication to the system, according to some embodiments. The communication to the system may be sent via email, text messaging, phone call, social media post, or from the user's system account which may be viewable on a system website, without limitation. The communication may contain the user's desired vanity ‘recipient’ address and/or the respective electronic addresses of the user's friends, relatives, contacts, co-workers, or the like, which are to be associated with (e.g., “linked to”) the user's desired vanity ‘recipient’ address.

FIG. 405 schematically suggests exemplary, non-limiting syntax which could be contained within the communication to the system described in FIG. 404, according to some embodiments, wherein multiple electronic addresses belonging to a single individual (e.g., future intended recipient) may be provided, and wherein the multiple electronic addresses may be assigned to a desired vanity address. In this regard, the user making the request communication to the system need only to provide the vanity address in future transaction requests made to the system, in order to send funds, credit, products, items, goods, or services to each of the multiple electronic addresses. Each time funds, credit, product, items, goods, or services are sent via the system from the user using the vanity address, the system may deduct an amount from the user's system account balance which may not be a multiple amount corresponding to the number of electronic addresses associated with the created vanity address. In other words, if five electronic addresses are associated with a created vanity address, and 5.00 worth of system credit or an item code that costs 5.00 in system credit is sent to recipients using the created vanity address, then 5.00 worth of system credit may be deducted from the user's system account balance. In such embodiments, similar or identical redemption information may be delivered to each electronic address, and therefore, if the recipient addresses belong to different individuals, only one of them may be able to redeem using the similar redemption information before the similar redemption information may be voided by the system. In some embodiments, only first electronic addresses associated with the created vanity address may receive redemptions in an insufficient funds scenario. In some embodiments, the system may apply discounts for transactions which may be made between multiple users.

FIG. 406 schematically suggests exemplary, non-limiting syntax which could be contained within the communication to the system described in FIG. 404, according to some embodiments, wherein multiple electronic addresses belonging to different individuals (e.g., a list of multiple future intended recipients) may be provided, and wherein the multiple electronic addresses may be assigned to a desired vanity address. In this regard, the user making the request communication to the system need only to provide the vanity address in future transaction requests made to the system, in order to send funds, credit, products, items, goods, or services to each of the individuals/multiple electronic addresses. Each time funds, credit, product, items, goods, or services are sent via the system from the user using the vanity address, the system may deduct an amount from the user's system account balance which may be a multiple amount corresponding to the number of electronic addresses associated with the created vanity address. In other words, if five electronic addresses are associated with a created vanity address, and 5.00 worth of system credit or an item code that costs 5.00 in system credit is sent to recipients using the created vanity address, then 25.00 worth of system credit may be deducted from the user's system account balance. In such embodiments, different redemption information may be delivered to each electronic address, and therefore, if the recipient addresses belong to the same individual, the individual may separately receive all of the sent funds and/or separately redeem each of the pieces of redemption information.

FIGS. 407-413D suggest methods of checking out ‘online’ (e.g., from a secure HTTPS or insecure HTTP checkout page, mobile checkout page, internet-based television/radio checkout page, or the like), with system-based account credit, using SMS, MMS, or mobile messaging.

FIGS. 414-421B suggest methods of checking out ‘online’ (e.g., from a secure HTTPS or insecure HTTP checkout page, mobile checkout page, internet-based television/radio checkout page, or the like), with system-based account credit, using email.

FIGS. 422-429B suggest methods of checking out ‘online’ (e.g., from a secure HTTPS or insecure HTTP checkout page, mobile checkout page, internet-based television/radio checkout page, or the like), with system-based account credit, using social media posting or other social media-based form of communication.

FIGS. 430-437B suggest methods of checking out ‘online’ (e.g., from a secure HTTPS or insecure HTTP checkout page, mobile checkout page, internet-based television/radio checkout page, or the like), with system-based account credit, using social media posting or other social media-based form of communication.

FIGS. 438-452 suggest other possible methods of checking out ‘online’ (e.g., from a secure HTTPS or insecure HTTP checkout page, mobile checkout page, internet-based television/radio checkout page, or the like), with system-based account credit, using SMS, MMS, or mobile messaging. It should be understood that while not explicitly illustrated, similar methods may be respectively utilized with phone-based, email-based, or social-media based communications, without limitation.

FIGS. 453-455 suggest some possible ways that a user may checkout online. The user may see a total amount due displayed on a checkout page. The user may also see a vendor electronic address, vendor vanity address, or item code recognized by the system. The user may quickly and readily purchase and receive a redemption code and/or redemption PIN from the system via an electronic communication to the system (wherein the redemption code and/or redemption PIN may be good for at least the total amount due), and then may receive the redemption code and/or redemption PIN. The user may then provide any one or more of the redemption code, redemption PIN, and/or the user's electronic address (e.g., electronic address used to make the electronic communication to the system), to one or more fields provided on the checkout page, and press submit to complete the transaction. The system may glean physical or shipping address information from a system profile/account which may be affiliated with the user's electronic address and stored in a system database (e.g., a MySQL table). The system may provide the gleaned physical or shipping address information, and provide it to the vendor, for the user, without the user necessarily needing to enter it or otherwise provide it in fields provided on the checkout page. Digital product information (e.g., secure download link or the like) may be sent directly from the vendor to the user, via the user's electronic address provided in the field(s) provided on the checkout page.

FIGS. 456 and 457 pertain to a method of creating an account for a second user upon a transaction request from a first user, regardless of whether the transaction request made by the first user may be contained within a communication to the system on an email-based, SMS/MMS/text/mobile messaging-based, phone call-based, web submission-based, or social media-based platform.

FIG. 458 pertains to a widget, according to some non-limiting embodiments, which may accompany any online item, product, good, or service displayed on a web page, website, or other digital electronic commerce platform (including television/box-top/smart TV/internet-based sets, gaming devices, mobile applications, and the like). The widget may show information necessary to complete the transaction via one or more of the following: text messaging (e.g., SMS, MMS, mobile messaging app), email, automated or in-person phone call, web submission using a system website, social media post. It should be understood that the pop-up shown may be permanently or semi-permanently displayed adjacent the item, product, good, or service, without interaction or operative engagement with the widget. It should also be understood that a system browser add-on may be used to facilitate display of the information. It should be further understood that the information may be provided on a separate webpage, such as a secure webpage or system webpage, rather than a pop-up. For example, if a user clicks on the widget, the user may be brought to a system webpage which displays similar information.

FIG. 459 pertains to a widget, according to some non-limiting embodiments, which may accompany any online item, product, good, or service displayed on a web page, website, or other digital electronic commerce platform (including television/box-top/smart TV/internet-based sets, gaming devices, mobile applications, and the like). The widget may show information, prompts, and/or input fields necessary to complete the transaction via the system, regardless of the vendor of the website/webpage. It should be understood that the pop-up shown may be permanently or semi-permanently displayed adjacent the item, product, good, or service, without interaction or operative engagement with the widget. It should also be understood that a system browser add-on may be used to facilitate display of the information. It should be further understood that the information may be provided on a separate webpage, such as a secure webpage or system webpage, rather than a pop-up. For example, if a user clicks on the widget, the user may be brought to a system webpage which displays similar information.

FIG. 460 pertains to a database record of the system (and/or third party affiliated with the system or linked to the system via system software). The record contains a listing of redemption information associated with a first user. The redemption information may be populated from previously-purchased items, goods, products, services, (which includes events), made by the first user, or sent to the first user by one or more second users. Each piece of redemption information may be associated with a single item, good, product, service, or multiple items, goods, products, services.

FIGS. 461-468 pertain to a method of redeeming one or multiple previously-purchased items, goods, products, services received through the system, (e.g., using system commands, instructions, communications, and/or protocols), according to some embodiments, in particular, by providing the user's electronic address, and an identification/authentication value, such as a repeated use PIN provided to the user upon the user's account creation. In some non-limiting embodiments, the repeated use PIN may be created by the user, or it may be provided to the user by the system (e.g., in the form of a PIN on a system card or third party system-affiliated card, such as a pre-paid card).

FIGS. 469-477 pertain to a method of redeeming one or multiple previously-purchased items, goods, products, services received through the system, (e.g., using system commands, instructions, communications, and/or protocols), according to some embodiments; in particular, by providing the user's electronic address, and an identification/authentication value, such as a one-time PIN provided to the user upon providing their electronic address during the redemption process.

FIGS. 478-486 pertain to a method of redeeming one or multiple previously-purchased items, goods, products, services received through the system, (e.g., using system commands, instructions, communications, and/or protocols), according to some embodiments; in particular, by providing the user's electronic address, and an identification/authentication value, such as a one-time QR code provided to the user upon providing their electronic address during the redemption process.

FIGS. 487-492 pertain to a method of redeeming one or multiple previously-purchased items, goods, products, services received through the system, (e.g., using system commands, instructions, communications, and/or protocols), according to some embodiments; in particular, by scanning a user QR code, which may be encrypted, and which may be a one-time QR code generated by a system application or third-party application affiliated with the system/system software. As shown, rather than a QR code that may be optically scanned, a near-field communication (NFC) protocol could be used, wherein the signal provided may be encrypted, or a one-time signal generated.

FIGS. 493-498 pertain to a method of redeeming one or multiple previously-purchased items, goods, products, services received through the system, (e.g., using system commands, instructions, communications, and/or protocols), according to some embodiments; in particular, by swiping a system card or third-party card affiliated with the system (e.g., a bank card, debit card, credit card, rewards card, loyalty card, gift card, pre-paid card, or the like). As shown, the system card or third-party card affiliated with the system may have access to the system database record shown in FIG. 460, and can extract redemption information associated with the card.

FIGS. 499-507 pertain to a method of redeeming one or multiple previously-purchased items, goods, products, services received through the system, (e.g., using system commands, instructions, communications, and/or protocols), according to some embodiments; in particular, by swiping a system card or third-party card affiliated with the system (e.g., a bank card, debit card, credit card, rewards card, loyalty card, gift card, pre-paid card, or the like). As shown, the system card or third-party card affiliated with the system may have access to the system database record shown in FIG. 460, and can extract redemption information associated with the card. In the particular embodiment shown, upon swiping, a one-time PIN may be sent to the user to enter into the payment terminal as an added layer of security. In some embodiments (as in FIGS. 508-515), however, the PIN may be a reusable pin that may be issued with the card, therefore obviating the need to receive a one-time PIN for each transaction. In some embodiments, the one-time PIN may comprise machine-readable indicia and/or an electromagnetic, optical (e.g., infrared), or sound signal (e.g., a NFC-compatible signal) which may be obtained by the user's mobile device, thereby offering a form of two-way authentication.

FIGS. 508-515 pertain to a method of redeeming one or multiple previously-purchased items, goods, products, services received through the system, (e.g., using system commands, instructions, communications, and/or protocols), according to some embodiments; in particular, by swiping a system card or third-party card affiliated with the system (e.g., a bank card, debit card, credit card, rewards card, loyalty card, gift card, pre-paid card, or the like). As shown, and similar to the embodiment shown in FIGS. 493-498, card or third-party card affiliated with the system may have access to the system database record shown in FIG. 460, and can extract redemption information associated with the card. In the particular embodiment shown, upon swiping, a reusable PIN may delivered/entered by the user, to a payment terminal as an added layer of security. In some embodiments, the reusable PIN may comprise machine-readable indicia and/or an electromagnetic, optical (e.g., infrared), or sound signal (e.g., a NFC-compatible signal) which may be obtained by the user's mobile device, thereby offering two-way authentication.

FIGS. 516-538 suggest various non-exhaustive, non-limiting embodiments of methods of remotely or proximally purchasing items, products, goods, or services, for someone else, and/or for remotely or proximally sending funds or credit to someone else who may or may not be a system member; for example, via text messaging (e.g., SMS, MMS, or mobile messaging via a system or non-system third party application). According to some embodiments, the system may preferably create an account for the recipient if the recipient may not be a system user at or around the time a transaction may be made. It may be further preferred that the account be created without further recipient interaction, wherein the recipient may utilize funds upon receipt, instantaneously. “Re-gifting” functions may also be advantageously employed, wherein redemption information, such as a redemption code and/or PIN or other pass code may be provided after the electronic address. While recipient phone numbers may be shown as recipient electronic addresses, sophisticated system parsing algorithms may enable a user to provide an email address, Twitter handle (or other social media profile user ID), system-recognized vanity electronic address, SIM card ID, IP address, or other conceivable electronic address or account number in lieu of a phone number. It is also envisaged that the 10-digit numbers representative of United States-based phone numbers shown, may vary for international use and application. The system may recognize intra- and international or intercontinental to/from electronic addresses, and may be configured to compensate for duties, taxes, import/export fees, or to restrict and prevent transactions from taking place, and the like, without limitation.

FIGS. 539-565 suggest various non-exhaustive, non-limiting embodiments of methods for remotely or proximally purchasing items, products, goods, or services, for someone else, and/or for remotely or proximally sending funds or credit to someone else who may or may not be a system member via email are disclosed. The system may, in some embodiments, automatically parse out the “Re:” preceding the one-time security pass codes delivered in email subject fields, and treat it as irrelevant information, processing only the pass code (to check the system database and verify the user's identity), and the amount, UPC code, or hashtag provided, to complete the request, along with the “from” field information. In some embodiments, the subject line or portions of the body may be used differently than as shown. For instance, one-time pass codes may be delivered in the body, and the subject line may be reserved entirely for system functions. The subject line, for instance, may be used similarly, in much the same fashion as the SMS-based/mobile messaging-based instructions shown and discussed herein. In some embodiments, various permutations of email-based and text-based transactions may be performed. For example, in less preferred embodiments, a user may link their phone's “email-equivalent” number (e.g., “7033146898@txt.att.net”, if the user is an AT&T subscriber), using the system's “LINK” command (or equivalent command) to thereafter, perform system communications, transaction requests, receive redemptions, and perform system functions, etc. According to some embodiments, one time pass codes may not be necessary, or a permanent or semi-permanent pass code may be utilized and re-utilized to make transactions through the system. According to some embodiments, a permanent or semi-permanent pass code may be used, instead of the number “1” as shown in the illustrated non-limiting embodiments. According to some embodiments, more than one pass code may be utilized in one or more portions of the email, and/or in one or more emails, in order to make a transaction, without limitation.

FIGS. 566 and 567 suggest one non-limiting embodiment of a step for checking a price of an item, product, good, or service; for example, using the command “cost” or the like, and an item code, such as the 12-digit UPC code shown, in a communication to the system (e.g., via a system application, SMS, MMS, or mobile messaging). It should be appreciated that other commands for checking costs, and/or other types of item codes (including, but not limited to “hashtags” or system-recognized vanity item codes) may be utilized in system communications, without limitation.

FIG. 568 suggests one non-limiting embodiment of liking an item, product, good, or service; for example, using the command “like” or similar command, and an item code, such as the 12-digit UPC code shown, in a communication to the system (e.g., via a system application, SMS, MMS, or mobile messaging). It should be appreciated that other commands for performing a “liking” function or otherwise providing a favorable opinion may be used, without limitation. Moreover, other types of item codes (including, but not limited to “hashtags” or system vanity item codes) may be utilized in system communications, without limitation.

FIG. 569 suggests one non-limiting embodiment of an error message that might be displayed if an item is not found in a system database, or otherwise supported by the system (e.g., for a non-system participating item, product, good, or service).

FIGS. 570 and 571 suggest one non-limiting embodiment of peeking (e.g., “spying”) on another system user, wherein a list of one or more recently liked items, products, goods, or services may be displayed; for example, using a command “peek” or similar command, and a system user's electronic address (for example, a user's mobile device number as shown). It should be appreciated that other commands for performing a “peeking” function or spying function may be used. Moreover, a plethora of other types of items, products, goods, or services may be displayed. In some non-limiting embodiments, most recently-liked items may be displayed. In some non-limiting embodiments, items on a user's wish list or “liked” list may be removed upon another user purchasing the items for the user. In this regard, users may not need to worry about duplicative/redundant gifting.

FIGS. 572 and 573 suggest one non-limiting embodiment of indicia; for example, a message containing alphanumeric indicia, which may be displayed to a user who is being spied upon, for example, using a system “peek” function. It is anticipated that other forms of image data may be displayed which might suggest that the user's wish list or list of “liked items, products, goods, or services” is being, will be, or was recently observed by another user.

FIG. 574 suggests one non-limiting embodiment of indicia; for example, a message containing alphanumeric indicia, which may be displayed to a user who may be trying to spy on another user's wish list or list of “liked” items, products, goods, or services. In some embodiments, users may be required to be “friends” with each other, in order to make such transaction requests. For example, a requesting user may be required to “friend” a user before peeking at their wish list or list of liked items. A “join” command or equivalent (e.g., “friend”, “buddy”, etc.) may be used to friend another system user or non-user. It should be understood that where used herein, the terms “friend(s)”, “buddy(s)”, “contact(s)”, “family(s)”, “family member(s)”, “co-worker(s)”, and the like, may be referring to an electronic address or physical address of the respective noun referring to an entity.

FIGS. 575-579 suggest one non-limiting embodiment of indicia; for example, a message containing alphanumeric indicia comprising instructions, which may be displayed to a user who is trying to accept or otherwise confirm a friend request via the system. In some embodiments, users may be notified (e.g., if they try to friend an electronic address that may already be recognized by the system as a friend), that they are already friends. In some embodiments, the system may employ scripts containing algorithms which simply ignore duplicate friend requests.

FIGS. 580-583 suggest non-limiting embodiments of steps for “re-gifting” received redemption information; for example, providing new recipient information (e.g., a new recipient electronic address or physical address), and/or one or more portions of the redemption information, as shown. It should be appreciated that other instructions may be displayed and/or complied with to perform similar re-gifting functions. It should further be appreciated that other commands may be included in the communications shown, without limitation. According to some embodiments, recycled/repurposed redemption information may be voided and new redemption information may be sent to the new recipient. In this regard, for some preferred embodiments, duplicate redemption information may be avoided.

FIGS. 584-588 suggest one non-limiting embodiment of using voice commands to provide an instruction to the system; for example, as shown, a gifting function.

FIGS. 589-591 suggest one non-limiting embodiment in which redemption information may be processed, or used; for example, by a vendor or merchant who may be willing to accept the redemption information. In the instant case shown, a vendor or merchant (or other redeeming entity honoring redemption information in exchange for funds, credits, items, products, goods, or services) may not need sophisticated payment terminals or payment processing equipment. It should be understood that in some preferred embodiments, the same redemption information may be used with other system components, such as a system kiosk, a system API, a system payment terminal or payment terminal configured with system software, a system application, a system website, etc., without limitation.

FIG. 592 suggests one non-limiting embodiment of a step of ordering an item, product, good, or service using the system; for example, by providing an item code or redemption information as shown.

FIGS. 593 and 594 suggest various non-limiting embodiments of steps which may be employed for linking a first user electronic address with one or more second electronic addresses, without limitation.

FIG. 595 suggests one non-limiting embodiment of a communication which may be made to the system in order to receive a first amount of a first denomination in exchange for redemption information. As shown, a “cash” command may be used; however, it is envisaged that other commands may be utilized to perform other functions, such as trading redemption information for other redemption information. For example, according to some embodiments, a “trade” command may be utilized, without limitation. According to some embodiments, a communication to the system comprising valid received redemption information and an item code may be interpreted by the system as a request to trade the redemption information for redemption information pertaining to the item code; wherein in some embodiments, the traded may be voided, new redemption information pertaining to the item code may be delivered, and any difference in value may be kept by the system or added to the users system credit balance or other account balance (e.g., system account balance or third-party account balance), without limitation.

FIGS. 596-603 show some non-limiting embodiments of various interactions with system components that can be made via a user interface 100 of a system platform. As shown, various transaction requests may be made via SMS, MMS, and/or mobile messaging, without limitation. However, it is within the spirit and scope of this disclosure that similar transaction requests may be made within social media 95 environments (e.g., in a social media post), within electronic mail environments (e.g., using email), during a phone call (e.g., human-conducted or automated hotline), via a web submission (e.g., on a system-integrated web page), through various interactions with a system-integrated mobile application 147, and/or the like, without limitation.

Though not expressly shown and described in this disclosure, U.S. Provisional Patent Application No. 61/989,823 schematically illustrates and explains some further non-limiting embodiments of a system and method for distributing, receiving, and using funds or credits according to various non-limiting embodiments. According to some embodiments, system inboxes may be set up to receive communications (by phone, text, email, or web form) from users who wish to a make a transaction request to a system. According to some embodiments, a system may send SMS messages to requesting or recipient users via SMS software, wherein the messaging software may be integrated with scripts, SMS gateways, mobile messaging software, and/or other hardware/software known in the art (e.g., those used for mobile marketing and mobile banking). According to some embodiments, incoming web form-filled field information may be configured to be delivered to an electronic inbox of a system, wherein scripts may be used to automatically populate information into a system database (e.g., MySQL, PHP, etc.) so that system processes, functions, and operations may be automated and/or scalable with or without significant human intervention. According to some embodiments, a user may provide transaction information to a system in a predetermined format, wherein an email sent and/or received by the system may be used with scripts, email parsing software, and the like, to automatically extract desired text and auto-populate a system database which may exist on one or more internally or externally-integrated system servers. According to some embodiments, a web-based confirmation page may be provided by the system upon completion of a transaction. According to some embodiments, a web-based form may be provided by the system to accept transaction information. According to some embodiments, a system web-based page may be utilized by a user of the system to electronically purchase system credit which may be recognized and/or accepted by system-participating vendors/selling entities. According to some embodiments, a system web-based page may be used to send system-affiliated items, products, goods, services, or funds from one system user to another person (which may or may not be a system user); for example, using electronic address information and/or phone information. According to some embodiments, a system web-based page may be used to activate physical or electronic system cards (e.g., of the “prepaid”, “gift”, “credit”, “debit”, or “EBT/Electronic Benefit Transfer” type) purchased or owned by activating users. According to some embodiments, the funds associated with the physical or electronic system cards may be associated with a user's information such as an electronic or physical address. According to some embodiments, purchased system funds/credits may be utilized with the activated phone and/or email address provided. According to some embodiments, only one electronic address may need to be required in other various embodiments. According to some embodiments, a method of sending funds or credits (e.g., for a pre-purchased item) from at least one of a first email address and a first phone number to one or more of a second email address and a second phone number. According to some embodiments, a human verification implement may be provided to improve system security and system robustness. According to some embodiments, a user may be required to create an account to perform various transaction functions; activate features (e.g., accounts); purchase items; products, goods or services; add address information; and set preferences (e.g., send item using merchant with lowest price, set default delivery to a certain vendor/selling entity, ship direct from manufacturer or retailer, etc.). According to some embodiments, providing phone and/or email address information may not be required from the user after logging in. According to some embodiments, a user may provide transaction information, for example, “sender info”, “recipient info”, and an “item code or amount of system funds/credits to transfer”. According to some embodiments, interactions using the system may be made using a smart phone having internet-connection/web address access capability, or a connection to a network as defined herein. According to some embodiments, the smart phone user may utilize the system website to perform transactions instead of through text messaging. The system may reply to the user using mobile messaging, SMS/MMS, email, or an automatic system-generated phone call for security and/or transaction verification, without limitation. For the sake of brevity, the figures within U.S. Provisional Patent Application No. 61/989,823 have been omitted from this disclosure.

Also, though not expressly shown and described in this disclosure, U.S. Provisional Patent Application No. 62/040,402 schematically illustrates and explains some further non-limiting embodiments of a system and method for distributing, receiving, and using funds or credits according to various non-limiting embodiments. Some of the figures show exemplary, non-limiting embodiments of various instructions that may be sent to and from the system or to and from a third party website configured with a system API, widget, plug-in, or the like. Some of the instructions shown suggest exemplary, non-limiting embodiments of system instructions to perform a function regarding a transaction, or instructions pertaining to a function to be made regarding a transaction. According to various embodiments, the instructions may be received from, or delivered to the system or third party website, via a social platform, email client/address, phone number, mobile device, or web submission. Subsequent communications may be sent to the sending/requesting user via the same platform, or via another platform the system supports (e.g., social media, phone, SMS text, MMS text, email, or the like). In particular, U.S. Provisional Patent Application No. 62/040,402 suggests methods of purchasing system credit from a brick-and-mortar facility of a participating vendor/selling entity, using a payment terminal, according to some embodiments; methods of purchasing system credit from a brick-and-mortar facility of a participating vendor/selling entity, using a mobile device (e.g., SMS, mobile messaging, social media, or email), according to some embodiments; methods of purchasing system credit in a brick-and-mortar facility of a participating vendor/selling entity, for someone else, using a payment terminal, according to some embodiments; methods of purchasing system credit in a brick-and-mortar facility of a participating vendor/selling entity, for someone else, using a mobile device (e.g., SMS, mobile messaging, social media, or email), according to some embodiments; methods of purchasing a product, item, good, or service found in a brick-and-mortar facility of a participating vendor/selling entity, for someone else, using a payment terminal, according to some embodiments; methods of purchasing a product, item, good, or service found in a brick-and-mortar facility of a participating vendor/selling entity, for someone else, using a mobile device (e.g., SMS, mobile messaging, social media, or email), according to some embodiments; methods of purchasing a product, item, good, or service found in a brick-and-mortar facility of a participating vendor/selling entity, for someone else, using a mobile device (e.g., SMS, mobile messaging, social media, or email), while shopping at the brick-and-mortar facility, according to some embodiments, and having the recipient (e.g., the “someone else”), instantly redeem the same product, item, good, or service, at the same or different brick-and-mortar facility, wherein the same or different brick-and-mortar facility uses a payment terminal during the redemption transaction; methods of redeeming a product, item, good, or service found in a brick-and-mortar facility of a participating vendor/selling entity, using a mobile device (e.g., SMS, mobile messaging, social media, or email), according to some embodiments; and methods of liking a product, item, good, or service found in a brick-and-mortar facility of a participating vendor/selling entity, using a mobile device (e.g., SMS, mobile messaging, social media, or email), according to some embodiments, wherein other system users may see the liked product, item, good, or service by sending a communication to the system which may include an electronic address and a system command (e.g., ‘PEEK’). For the sake of brevity, the figures within U.S. Provisional Patent Application No. 62/040,402 have been omitted from this disclosure.

Moreover, while not expressly shown or described herein, figures contained within U.S. Provisional Patent Application No. 62/053,157 suggest non-exhaustive, non-limiting embodiments of promotional advertisement uses of the system and methods disclosed herein. For example, suggested is a non-exhaustive, non-limiting embodiment of purchasing a DVD movie rental from a movie kiosk using system credit via a web-form. It should be appreciated that any item, product, good, or service may be purchased in a similar manner, and that the particular item code (e.g., “hashtag”) shown may be altered for various products and services to accommodate alternative conceivable pre-paid transactions (e.g., “redbox2” for two pre-paid DVD movie rentals”, or “redboxgame5” for five free movie rentals, or “redboxDVD”, “redboxgame”, etc., without limitation). According to some embodiments, credit or funds may also be purchased in a similar manner. As shown, a UPC code, SKU number, vanity item code (e.g., “hashtag”), or the like, may be provided. In some embodiments, a user may have the additional option(s) select from multiple fields so that they can use funds from at least one of: a social media address, a phone number, an email address, system account number (e.g., prepaid physical or electronic gift card number), system account PIN (e.g., prepaid physical or electronic gift card PIN), or the like. In some embodiments, a user may have the additional option select from multiple fields so that they can send funds, credit, items, products, goods, or services, to at least one of: a social media address, a phone number, an email address, or system account number belonging to a single person. In some embodiments, a user may have the additional option select from multiple fields so that they can send funds, credit, items, products, goods, or services, to at least one of: a social media address, a phone number, an email address, or system account number belonging to multiple persons. In some embodiments, a user may have the additional option select from multiple fields so that they send various combinations and permutations of amounts, and/or multiple different items, products, goods, or services in a single web-form submission. Item codes (e.g., “hashtags”), where used herein and where used in co-pending and priority applications to this disclosure, may be associated with a vendor, a price, and at least one of the following: one or more products, one or more items, one or more goods, one or more services.

While the certain embodiments shown may illustrate practical ways to utilize features offered by embodiments of systems and methods of the present invention, it should be realized that users may also link electronic addresses through user agreements with the system, or by other, more direct/personal means of system communications (e.g., via customer help hotline). It should also be appreciated that users may send system credit, items, products, goods, or services while checking out online or at a brick-and-mortar store of a participating vendor/entity, including through a system website. In this regard, a user may purchase and pay for system credit to be sent to another individual(s) conventionally, the participating vendor/entity may utilize the system, system methods, or components thereof to convey the purchased system credit to the another individual(s), and the another individual(s) may electronically receive the purchased system credit from the participating vendor/entity on behalf of the user and use the system credit immediately. A user may also purchase and pay for an item(s), product(s), good(s), or service(s) to be sent to another individual(s) conventionally, the participating vendor/entity may utilize the system, system methods, or components thereof to convey the purchased item(s), product(s), good(s), or service(s) to the another individual(s), and the another individual(s) may electronically receive redemption information to redeem the item(s), product(s), good(s), or service(s) from the participating vendor/entity on behalf of the user and use the redemption information immediately (e.g., visit a participating vendor/entity physical or online location, pick up/order the item(s), product(s), good(s), or service(s), proceed to checkout, and simply provide the redemption information at checkout). This may save the user's time and money, which might be spent packaging and/or shipping/mailing physical items.

Some of the figures show exemplary, non-limiting embodiments of various instructions that may be sent to and from the system. Some of the instructions shown suggest exemplary, non-limiting embodiments of system instructions to perform a function/execution regarding a transaction, or instructions pertaining to a function/execution to be made regarding a transaction; for example, a redemption of redemption information pertaining to one or more pre-paid or partially pre-paid items, products, goods, or services which may have been pre-purchased by the respective user or a person other than the respective user.

Some of the instructions shown suggest exemplary, non-limiting embodiments of system instructions to perform a transaction or function, wherein the instructions may be received from a social platform. According to some embodiments, a series of one or more subsequent communications may be sent to the sending/requesting user and/or recipient user(s) via the same social platform, or via another platform the system supports (e.g., phone, SMS text, MMS text, email, or the like).

It should be appreciated by those having an ordinary skill in the art, from this disclosure, and the disclosure within the co-pending applications listed above, that method steps schematically illustrated in the figures may be practiced, with occasionally equal benefit, using different electronic communications platforms (e.g., email, SMS/MMS/text/mobile messaging, phone call, or social media), without limitation.

Some of the figures show exemplary, non-limiting embodiments of various instructions that may be sent to and from the system, or to and from a third party website configured with a system API, widget, plug-in, or the like. Some of the instructions shown may suggest exemplary, non-limiting embodiments of system instructions to perform a function regarding a transaction, or instructions from a third party website pertaining to a function to be made regarding a transaction. According to various embodiments, the instructions may be received from, or delivered to the system or to the third party website, via a social platform, email client/address, phone number, mobile device, or web submission. Subsequent communications may be sent to the sending/requesting user via the same platform, or via another platform the system supports (e.g., social media, phone, SMS text, MMS text, email, or the like).

Some of the instructions shown suggest exemplary, non-limiting embodiments of system instructions to perform a function regarding a transaction, or instructions pertaining to a function to be made regarding a transaction.

According to various embodiments, instructions may be received from, or delivered to the system, or to a third party website, via a social platform, email client/email address, phone number, mobile computing device (including wearables and connected car systems), or web submission (including those made from an internet-based “box-top” television platform). Subsequent communications may be sent to the sending/requesting user via the same platform, or via another platform the system supports (e.g., social media, phone, SMS text, MMS text, email, or the like).

Moreover, method steps similar to those disclosed in this application and co-pending applications may be used to redeem credit delivered, purchased, and/or received via the system or system protocols, for example, a user may receive a cash amount in exchange for system credit (with or without exchange fees), wherein the records shown may further contain a system account balance record associated with an electronic address (e.g., a mobile phone number).

As may be appreciated from this disclosure, using a system according to some non-limiting embodiments, online shopping websites may be thought of as “online catalogues”, wherein a separate mobile device, email client, phone, or third party platform may be used to complete the payment and delivery of items, products, goods, or services, rather than through the online shopping website's secure checkout page.

Accordingly, while the certain embodiments shown may illustrate practical ways to utilize features offered by embodiments of systems and methods of the present invention, it should be realized that various permutations, combinations of steps/features, and adaptations which may not be expressly shown, are anticipated.

It will be readily appreciated by those having an ordinary skill in the art, that an exhaustive listing and detailed description of all possible additional embodiments and possible permutations conceived by the inventor (which would fall within the scope and spirit of the invention) cannot be concisely described herein. However, the inventor has put forth a substantial number of various exemplary embodiments to suggest at least some possible or “practical” ways that the invention may be practiced.

### DETAILED DESCRIPTION OF EXEMPLARY EMBODIMENTS

While this invention is susceptible of embodiments in many different forms, there is shown in the drawings and will herein be described in detail, preferred (or otherwise most simplistic) embodiments, with the understanding that the present disclosure is to be considered as an exemplification of the inventive concepts and principles of the invention and is not intended to limit the broad aspect(s) of the invention to only the embodiments disclosed and/or illustrated.

For the purpose of understanding and/or better appreciating inventive features and concepts, various trademarks of third parties may be used in various manners throughout this disclosure and the appended drawings. Such use of third party trademarks herein is made purely for “illustrative purposes”, for example, to suggest some “hypothetical embodiments”, to suggest some “possible best modes”, to suggest some “possible advantageous uses”, and/or to suggest some “possible applications” of the inventive features and concepts disclosed. In no way should the use of third party trademarks herein suggest that the inventor/applicant is affiliated with any corporation or entity associated with third-party trademarks disclosed herein. Moreover, the use of third-party trademarks herein does not suggest that embodiments, inventive features, or inventive concepts are already affiliated with or already in use by others. The inventor has taken measures to use third-party trademarks appropriately; for example, by distinguishing third party trademarks with capitalization in the text and/or by conveying third-party trademarks and trade dress in the drawings in a manner which would not otherwise dilute or disparage a third-party trademark. The embodiments disclosed are representative of prototypes or conceptual applications which have not been released to the public or otherwise used in commerce for commercial purposes. Furthermore, the use of specific trademarks of third parties is in no way intended to limit any embodiment to the particular items, products, goods, or services shown and described.

Embodiments are drawn to systems and methods for distributing, receiving, and/or using funds or credits, as well as apparatus thereof. Embodiments of apparatus may be directed toward kiosks, such as card dispensing and/or redeeming machines. Embodiments may be directed toward authentication methods, such as authenticating cards purchased from card dispensing and redeeming machines and/or authenticating transactions made using system components (e.g., through a system website or to system server or server computer via the internet). Embodiments may further be directed toward a system and method for vendors or selling entities to directly or indirectly facilitate consumer purchases, transactions, and redemptions. Moreover, embodiments may be directed toward a system and method for utilizing funds or credits, for example, funds or credits associated with cards or electronic addresses; wherein the funds or credits may be utilized for consumer use with participating vendors or selling entities 65 of various types.

Kiosk apparatus described herein may preferably incorporate robust, secure, and/or scalable software; for example, software that may provide a fully personalized user experience and/or real-time feedback to hosting locations and/or third parties (e.g., advertisers), voice-recognition software, speech-to-text software, text-to-speech software, image scanning software, image reading software, decoding software, encoding software, and the like. Kiosk apparatus described herein may incorporate hardware that may leverage existing technologies such as touch screen, focused audio speakers, audio input/recording devices, data input means, image scanning technologies, camera image capturing devices, digital reading mechanisms, and video monitors (e.g., LED, LCD, or plasma). Kiosk apparatus described herein may incorporate technology utilizing the internet, satellite, or cellular network systems, as well as a myriad of other communications systems and platforms; for example, to access or communicate with a system website, system software, system hardware, and/or one or more system databases (e.g., stored on a system-integrated server). Kiosk apparatus described herein may comprise secure blank card storage means, such as one or more hoppers or magazines that may discourage theft or fraudulent activities. Kiosk apparatus described herein may securely facilitate the transfer of funds or credits between each machine; for example, with little need for human intervention other than by its users (e.g., a purchaser and/or a recipient). These technologies and others that will be described herein may fill long-felt needs in the art and/or may provide advantages over conventional gift card and redemption information purchase and distribution options known in the art. Kiosk apparatus according to some embodiments may function as much as a promotional platform as it might serve as a vehicle for consumer convenience.

By utilizing the apparatus and fully-interactive, real-time, linked internet website according to some embodiments, consumers may be able to buy, transfer, sell, alter, reallocate, receive, redeem, or deliver one or more vendor-accepted/vendor-recognized credits or funds, and/or various forms of redemption options and/or redeemable electronic cash. In some embodiments, the system may support similar functions for gift cards, coupons, redemption codes, tickets, passes, vouchers, prepaid phone minutes, petty loans, lottery articles such as scratch-off tickets or lottery tickets, currency (including domestic, foreign, cryptographic, and other forms of electronic/digital currency), and/or other consumer-based or merchant-based purchasing funds or credits. According to some embodiments, the aforementioned functions may be performed directly, as well as indirectly, between system components; for example, by making a transaction (e.g., a reservation) through the system website or system application (e.g., using a mobile device or computing device) for later pickup and/or redemption at a conveniently located kiosk machine.

According to some embodiments, system components (for example, kiosks, mobile devices, payment terminals, servers, networks, databases, architectures, structures, and computing devices integrated with the system, without limitation) may preferably be networked with each other and/or configured to access a shared database which may comprise virtual inventory, digital codes, digital management software, user interface algorithms, secure encryption/decryption software, user profile(s) information, personal data, marketing strategies, and/or business models, without limitation. Where used herein, the term “component” (e.g., a system “component”, or a “component” of the system and/or method) may broadly refer to any feature, device, network component, data structure, software, firmware, hardware, computer code readable by a machine, algorithm, platform, algorithmic step, function, execution, operation, communication, hierarchy structure, architecture, input, output, action, logic, or step described, without limitation.

According to some embodiments, access to a system website and/or a system database by virtue of a system-integrated server may be achieved using a phone-line, a dial-up connection, a DSL connection, a wireless protocol, an Ethernet connection, a network link, a cable/hard-wired connection, Bluetooth wireless connection, or other internet connection means, including line-based connection means, wireless connection means (e.g., cellular and/or satellite network connection means), Dial-up ISP connection means, ADSL connection means, Cable connection means (e.g., cable modem), broadband connection means, and/or fiber optic connection means, without limitation. According to some embodiments, methods may make use of texting (e.g., providing text to an information field with physical, audio, or gesture inputs) with a mobile device; for example, to expand the number of client venues and/or locations. The system may comprise a number of potential client venues and/or locations and/or potential hosting venues or locations. Through this linked network, the experience for each consumer may be customized based on a profile for each consumer. According to some embodiments, profiles may contain a number of identifying information elements which may include electronic address information, SIM card identification number information, mobile phone number information, network communications metadata information, transaction metadata information, user preferences, and/or card number information, without limitation. According to some embodiments, a system may incorporate means such as personalized home pages, for example, on a system website. The home pages may or may not be required to be accessed by a customer to use system features). According to some embodiments, a system component such as a website, a kiosk, a software application, a system widget, a system communication, or the like, may employ targeted advertisements, purchase or redemption recommendations, user opinions of items, products, goods, or services, purchase preferences, redemption preferences, tutorial/help screens, user instructions, interactive media, and other user types of preferences, without limitation.

Cards disclosed herein, including cards which may be produced in certain non-limiting embodiments of the system, method, and apparatus thereof, may be used as a convenient means for transferring funds and/or credits between users. Unlike conventional online escrow services (e.g., PayPal) and money transfer services (e.g., Western Union), a first user may access a system website, system application, mobile device configured to communicate with system components, and/or a system-integrated kiosk to purchase a gift card or redemption information, without limitation. According to some embodiments, a system-integrated card may be purchased from a display rack at a retailer and activated by various means described herein. According to some embodiments, a system card may be manufactured by a kiosk. According to some embodiments, the card may be supported by (e.g., able to be used with existing infrastructure), may be affiliated with, or may otherwise be recognized and/or processable by a leading well-established bank or major credit card company (e.g., VISA, Chase, US Bank, Bank of America, Discover Financial, American Express, MasterCard, etc.). According to some embodiments, a first user may designate a second user as a recipient of the funds or credits; for example, using mobile phone number contact information affiliated with the second user which may already be stored in the first user's mobile device (e.g., in a “contacts” list) or otherwise may be accessible by, from, or using the first user's mobile device. According to some embodiments, a second user may be able to instantly redeem a received gift card (whether physical or electronic). According to some embodiments, a second user may not “physically” need to possess a gift card to use the gift card. According to some embodiments, funds or credits associated with a first card may be transferred to a second card using a simple electronic communication to a server containing programming code which may contain one or more algorithmic expressions and which may be configured to manipulate a database(s). According to some embodiments, a second user may use the funds as an equivalent to cash at participating vendors; for example, to perform transactions pertaining to items, products, goods, or services. According to some embodiments, a second user may use a system component, such as a system card, mobile device, system application, system-integrated kiosk, and/or system-integrated payment terminal, without limitation, to redeem funds or credits as cash/local currency or as equivalent thereof. At the time a sale is made by a first user (e.g., a “purchaser”, “purchasing user”, or “user making a transaction using a system component”), a fee may be charged or deducted from the funds to be transferred, and/or a security feature may be provided. According to some embodiments, the security feature may comprise a password, an authorization code, and/or unique image means (such as a bar code or data matrix code, without limitation) which may be sent to the first user and/or the second user via email, voicemail, social media platform, or text/SMS/MMS/mobile message, or web-based profile, without limitation. For example, in some non-limiting embodiments, the security feature may comprise a digitone or sound bit delivered by voicemail to the mobile device of a first and/or a second user. Upon redemption by a second user, the security feature may be requested by the respective terminal or kiosk being used by the second user to perform a transaction. According to some embodiments, the security feature may be received, read, processed, and/or used using appropriate reader means provided to the respective terminal or kiosk.

In some embodiments, the system may employ or otherwise comprise a card “blank” from a supply of blank cards, which may have a security feature thereon such as a code, hologram, ultraviolet ink, embossment, chip/integrated circuit, antenna, RFID tag, near-frequency communication (NFC) device, or magnetic information that cannot be easily reproduced or forged, without limitation. In some embodiments, upon activation through a kiosk, the card may be provided with digital information, for example, unique encrypted authentication information, such as a data matrix code, bar code, magnetic information, character string, resonant frequency, software/application, data file, or other data storage means known in the art, without limitation. In some embodiments, upon activation by calling a system electronic address (e.g., system phone number) and providing a card number, PIN, and/or activation code; or upon activation by texting a card number, PIN, activation code to a system electronic address (e.g., e.g., a system phone number, short code, long code, or email address) via a mobile device, the card user's mobile device (e.g., phone or wearable) may be provided with unique encrypted or non-encrypted authentication information, such as one or more data matrix codes, bar codes, character strings (e.g., “image data”), resonant frequency, audible signal (e.g., “audio data”, such as a digitone or sound bite), software/application, link to a website, data file, or other data storage means known in the art; wherein in some embodiments, the user may be required to re-enter or otherwise provide back to the system (i.e., a system component), system-sent authentication information. According to some embodiments, the unique encrypted authentication information may be associated with one or more verification/validation information such as one or more keys, passwords, PINs, passphrases, pass codes, a “lost or stolen card” security number (e.g., an account number or reference number for later reporting, etc.), or user-data (e.g., email address, phone number, name, or other identifying personal information), without limitation. According to some embodiments, the authentication information and/or the verification/validation information may be used during a redemption of an item, product, good, or service, or may be used for another type of transaction (a registration for an event). For example, according to some embodiments, the authentication information and/or the verification/validation information may be used during a use of a system card; for example, if a redemption action or transaction is made at a payment terminal, on an online website (e.g., a system website or third-party website), or through the use of a software application (e.g., a system application or third-party application, including mobile applications and/or payment terminal software applications, without limitation). According to some embodiments, the authentication information and/or the verification/validation information may be used during a use of a system card, whether it be at a kiosk within the system, online via a website (e.g., a system website or third-party website), using a software application (e.g., a system application or third-party application, including mobile applications and/or payment terminal software applications, without limitation), using a software application which may be supported by or operably connected with the system website and/or server, and/or used at a participating entity, without limitation.

According to some embodiments, the system may provide another vehicle for vendors to provide refunds or return credits; for example, without dispensing cash (e.g., without actually dispensing cash from a cash register and/or requiring the same credit or debit card used to make a prior purchase in order to credit the credit or debit card). A disadvantage which may be observed with conventional gifting systems is that typically, merchants will only credit the original payment card which was used to purchase the item or gift card, or they will generally not accept refunds, or they will provide store credit by issuing a new gift card which is only redeemable at the same issuing vendor/selling entity. Cards disclosed herein may be credited with more universally accepted system-recognized credits which may be honored at a number of non-affiliated vendors/selling entities who participate in the system.

Certain embodiments may provide convenient means for performing an on-demand redemption of funds or credits purchased by or given to a user; means for making on-demand payments using funds or credits purchased by or given to a user; means for enabling on-demand sharing of information, for example, in instances where a user may not be able to access the internet to update profiles or perform profile functions (e.g., social network functions like posting, recommending, or “liking” things); means for executing on-demand functions like sending of funds, credits, or redemption information for items purchased by or given to a user; and/or means for enabling on-demand purchasing of items, products, goods, or services, without limitation. Some embodiments may employ one or more security features for enhancing security.

Some embodiments may allow customers to improve their shopping experiences by integrating navigation systems and/or positioning technologies with their shopping and/or social activities, for example, to facilitate the location of certain items, products, offerings, goods, or services in advance and/or in real-time, as well as retroactively, to review or track patterns, habits, or the like regarding the same. Some embodiments may improve customer shopping experiences; for example by integrating custom digital shopping or wish lists, gift card credit(s), coupons, vouchers (including pre-paid vouchers), customer loyalty benefits, electronic cash, and/or relevant targeted advertising, into a single system.

Embodiments of the system may overcome many of the drawbacks of conventional gifting and/or authentication systems, in that certain embodiments of a system may be inexpensive or simple to implement, may not be easily defeated through simple means for duplication or alteration, and/or may be configured with robustness for at least the reason that embodiments of the system may not be prone to false rejections and/or vendor systems which may be outdated.

Components of the system may, in some embodiments, be used as or similarly to a gift card by the purchaser, for example, even without sending or otherwise providing a physical card to the recipient. According to some embodiments, a gifter (e.g., a gifting “user”) may use the same card as a secure “shopping card” to make small everyday purchases, without planting personal bank or credit card account information in every vendor's financial database. In this regard, card components of the system may have gifting and purchasing uses, as well as other uses. According to some embodiments, in instances where a system card may have been compromised, a worst case scenario may comprise the steps of a user buying a new system-integrated card, activating the new system-integrated card, and/or transferring funds or credits to the new system-integrated card; for example, using an automated audio human machine interface (HMI), for example by calling a system electronic address (e.g., a phone number). According to some embodiments, a person may be notified that a card is already on file with a person's mobile phone number. According to some embodiments, a person may be prompted, via a visual and/or an audible menu, one or more options. The one or more options may include, regard, or pertain to an option to select a preferred language preference, an option to transfer of funds or credits to a new card, an option to temporarily suspend activity associated with user data (e.g., a user account which may be affiliated with a user electronic address), and/or an option to expunge or combine all accounts associated with an electronic address (e.g., a mobile device number or unique SIM identification code), without limitation.

According to some embodiments, a user may redeem (e.g., “utilize”) redemption information (e.g., which may comprise one or more redemption codes which may be alphanumeric in nature and/or image-based in nature) in exchange for one or more items, products, goods or services associated with the redemption information; for example, by scanning image data using a component of the system. According to some non-limiting embodiments, the image data may comprise an MMS-based image, for example, an image which may have been sent from a component of the system or system affiliate (which may be or may comprise a vendor, merchant, or manufacturer of the one or more items, products, goods, or services being sent by the system), to the user. The step of scanning of the image data may take place, for example, at a point of sale venue/location of a participating entity, such as a vendor, merchant, selling entity, or organization which may carry or otherwise be able to redeem and/or provide the one or more items, products, goods or services associated with the redemption information in exchange for the redemption information. In some instances, redemption information (which may be redeemed or otherwise used to receive the one or more items, products, goods, or services) and/or the one or more items, products, goods, or services, themselves, may relate to or otherwise pertain to an event, fare, admission, entry fee, registration, subscription, charitable drive, combinations thereof, or the like (which may be fully or partially-pre-paid for), without limitation. For example, the one or more items, products, goods, or services may relate to races, charitable dinners, charitable sponsorships, entrance fees, concerts, sporting events, or other “type” of redemption information disclosed herein, without limitation.

According to some embodiments, a user may redeem redemption information (e.g., which may comprise one or more redemption codes which may be alphanumeric in nature, audio-based, and/or image-based in nature); for example, by providing the redemption information to an employee or representative of a participating entity, such as a vendor, merchant, selling entity, or organization which may carry or may otherwise be able to redeem the one or more items, products, goods or services associated with the redemption information, without limitation. According to some embodiments, a user may redeem redemption information by providing the redemption information to a payment receiving means, such as a payment terminal of a participating entity which is preferably integrated with the system. The redemption information may comprise one or more alphanumeric codes, one or more pieces of audio data, and/or one or more pieces of image data, without limitation.

According to some embodiments, a user may redeem redemption information for one or more items, products, goods or services associated with the redemption information by “re-gifting” the redemption information to a participating entity which may carry or may otherwise be able to redeem the one or more items, products, goods or services associated with the redemption information. In such embodiments, the participating entity which may possess or may otherwise be able to redeem (e.g., provide in exchange for redemption information) the one or more items, products, goods or services associated with the redemption information, may provide an electronic address at a point of sale, for example, in its own physical, electronic, or virtual (e.g., “online”) environment. For example, in some embodiments, a sign comprising indicia suggesting “To redeem via the system, please send your redemption code(s) to <electronic address>” may be placed in a physical venue/location of the participating entity, wherein the <electronic address> may be selected from any of the types of electronic addresses mentioned or described in this, related, or co-pending applications. As another example, an online or virtual marketplace of a participating entity (e.g., a “third-party”) may similarly indicate “To redeem via the system, please send your redemption code(s) to “<electronic address>”.

In some embodiments, the user may provide the electronic address in a communication to the system, along with some, portions of, or all of the redemption information, as necessary to complete a transaction. According to some embodiments, the communication may or may not necessarily accompany a system-recognized command or keyword. According to some embodiments, the system may, upon receipt of the communication, void the user's provided redemption information, may create new redemption information (e.g., which may comprise one or more new redemption codes which may be alphanumeric, audio-based, and/or image-based in nature), and may send the new redemption information to the indicated electronic address of participating entity. The participating entity may receive the old and/or new redemption information from the system; for example, via the platform associated with the electronic address. In some embodiments, the participating entity may redeem the received redemption information for another form of funds and/or credits instantaneously (e.g., through the use of a system API integration with a payment terminal of the participating entity, and/or integration with third-party software, such as financial institution or financial service software). In some embodiments, the participating entity may aggregate redemption information received from the system or from users of the system, and may periodically present the aggregated redemption information to the system physically or electronically (e.g., to a customer service representative of the system who accesses a system database, or by entering redemption information data into fields or uploads via an online portal (e.g., user “profile”) of the system website) for reimbursement. In some embodiments, reimbursement from the system to a participating entity may be in the form of a cash value of the aggregated redemption information collected over time, as typically done with paper coupons and clearing houses). According to some embodiments, the system may electronically credit an account balance of the participating entity (e.g., a system credit account balance, or a third-party account balance, such as a financial institution account balance). Such transfers may, according to some embodiments, be performed using ACH transfer, direct deposit, wire-transfer, money order, check, or other means for electronic transfer known in the art, including third-party payment service platforms like PayPal, without limitation. According to some embodiments, the account balance may be, or may comprise, a system account balance containing system-recognized credit which may be arbitrary in denominational unit or fixed to a common currency (including cryptocurrency), such as to U.S. dollars (USD). According to some embodiments, the account balance may be, or may comprise, a third-party account balance (e.g., funds or credits from a merchant, social platform, or other entity). According to some embodiments, the system may provide reimbursement to the participating entity in the form of a check, electronic funds transfer (EFT), and/or direct deposit, without limitation.

According to some embodiments, the participating entity may, for example, receive, de-code, decrypt, and/or parse incoming communications (e.g., data communications, internet communications, wireless communications, emails, texts, mobile messages, signals, faxes, social communications, or other electronic communications, without limitation) originating from the system, may store the information into a database (e.g., MySQL table) on their own third-party server (e.g., in a proprietary format), may generate a list of redemption information (e.g., text/character-based redemption codes, image-based redemption codes, and/or audio-based redemption signals, which may include PINs and/or claim codes); and/or may provide redemption information electronically and/or physically, to the system (e.g., to a system processing facility or uploaded to a system database). In this regard, the system and/or participating entity may share data relating to redemption information, contents thereof, and/or status (e.g., void, null, not-purchased, purchased, active, inactive, etc.).

In some non-limiting embodiments, the system (via one or more system components described herein) may be configured to recognize an electronic address contained within a communication originating from a user and received by a component of the system, as a “redeem only” system user electronic address (e.g., an electronic address of a merchant, physical marketplace, online marketplace, or retailer participating entity who might only choose to accept redemption information in exchange for funds and credits). In such cases, the system may automatically void redemption information contained within the communication made to the system, and credit the system account and/or a third-party account associated with the electronic address of the “redeem only” system user. For example, in some embodiments, a system database may comprise a table, array, data structure, or list of “redeem only” system users which may be checked after receipt of an incoming communication to the system suggesting a transaction request. In this regard, redemption information may not be inadvertently “re-gifted” to the “redeem only” system user's electronic address. In some non-limiting embodiments, the system (via one or more system components described herein) may be configured to recognize an electronic address used to deliver an incoming communication as a “redeem only” system user electronic address (e.g., by POST input, caller identification, header parsing, or the like), without limitation. In such latter embodiments, a “redeem only” system user may only need to include redemption information in a communication to the system to void the redemption information and be reimbursed by the system for any items, products, goods, or services exchanged for the respective voided redemption information, and may not need to include their (own) electronic address information.

According to some embodiments, funds or credits contained within a system account associated with an electronic address may be exchanged for cash or other form(s) of funds or credits (e.g., currency or equivalent thereof) at any time. For example, according to some non-limiting embodiments, a user (e.g., a normal user or a “redeem only” user) may submit a physical, verbal, or electronic request to the system requesting a “cash-out” or “withdrawal” function to be executed. In some embodiments, the cash or other form(s) of funds or credit may be transferred physically or electronically in any conventional manner known in the art. In some embodiments, a small fee or deduction may be made upon this “cash-out” or “withdrawal” step, (e.g., as a token appreciation fee to the system for attracting a redeeming user to the physical, electronic, or virtual marketplace/website/location of a participating entity). In some embodiments, any one or more of the above-mentioned steps (e.g., redemption process steps) may involve an instruction being communicated to the participating entity, from the system, for example, requesting a claim code, PIN code, or incidental information of the user (e.g., a last 4 digits/characters, a first three digits/characters, a set of digits/characters, or a predetermined number of digits/characters or sequence of digits/characters from the user's electronic address and/or system card). In this regard, according to some embodiments, the participating entity may provide a respective claim code, PIN code, and/or incidental information back to the system immediately, or ultimately, upon an exchange of voided redemption information for funds, credits (e.g., system credit), cash, or cash equivalent (e.g., electronic money). The communication may be sent to the system on the same or on a different platform as the platform used to receive the communication containing the instruction. In some embodiments, rather than, or in addition to requesting a claim code, PIN code, or incidental information of a redeeming user, image data, audio data, and/or card data held by a user performing a redemption transaction may be provided to the system, via the participating entity (e.g., by the redeeming user providing card indicia verbally to an employee for entry into a data field of a payment terminal software application browser displayed on the payment terminal for recordation purposes, by the redeeming user providing card data electronically or physically to a payment terminal, by producing scannable static or moving machine-readable electronic images stored on a user's mobile device to a payment terminal reader/decoder/decryption software, by projecting a signal such as electromagnetic waves, radio waves, sound waves and/or light waves from a user's mobile device to a payment terminal reader, or the like, without limitation)

In some instances, redemption information may be created, handled, and/or managed internally by participating entities in their own proprietary ways, wherein the system, system methods, system apparatus, and/or components thereof may, in some embodiments, merely act as a service vehicle for performing transactions for the participating entities. In some embodiments, a participating entity may generate and provide redemption information directly to a recipient user's electronic address or profile, on behalf of the system; for example, wherein a participating entity server may be configured such that when one or more instructions pertaining to one or more system functions are included in an electronic communication from a user electronic address to a participating entity electronic address, and the one or more instructions fall within the scope of, or are similar to system instructions and/or user inputs disclosed herein, the participating entity may electronically deliver redemption information directly to the recipient user's electronic address in a similar manner as the system would. In some embodiments, the participating entities 65 may create and/or provide their own redemption information (including, but not limited to codes, signals, indicia which may or may not be machine-readable, electronic coupon data, or other redemption information types) to the system database in advance (e.g., physically deliver media containing the redemption information to a system facility or electronically submit or upload redemption information to the system through a system website component, e.g., profile, portal, or system database-accessing software/API), so that the system may fulfill transaction requests made through communications made to the system, on behalf of the participating entities. In some embodiments, the system, upon receipt of a transaction request communication from a user, originating from the user's electronic address, to one or more of the system's electronic addresses, requesting that one or more items, products, goods, or services be sent to one or more recipients, may, in real time, or in queue, send one or more request communications to the involved participating entities which are associated with or otherwise involved with the redemption information to be sent to the one or more recipients. In some cases, receipt information may be sent in a communication to the electronic address of the user requesting the transaction. According to some embodiments, the one or more requests to the involved participating entity(ies) may ask for, or otherwise request one or more pieces of proprietary redemption information (e.g., one or more alphanumeric, audio-based, and/or image-based redemption codes) which are to be sent in a subsequent communication to the system, in order for the system to complete the transaction. The involved participating entity(ies) may generate (e.g., in real-time), and/or retrieve (e.g., from a third-party database) the system-requested one or more pieces of proprietary redemption information, and then transmit the system-requested one or more pieces of proprietary redemption information to the system in a communication to a system electronic address. The system may, in turn, forward the system-requested one or more pieces of proprietary redemption information to the one or more intended recipients in respective electronic communications as necessary, on behalf of the involved participating entity(ies), to complete the transaction. It is also envisaged that in some embodiments, rather than the system requesting proprietary redemption information from the involved participating entity(ies) in real-time or “on-demand”, as transaction requests are made in communications to the system and received by a system electronic address, participating entity(ies) may provide redemption information to the system in advance; for example, uploaded to a system database or table thereof, so that the system may extract, provide, and deliver redemption information to users and complete transactions without periodic requests being made to the participating entity(ies), and/or without interruption or superfluous “middle-man” requests. In this regard, the process may, in some embodiments, be streamlined and/or the system, methods, and apparatus thereof may require fewer integrations with third-party infrastructure(s), platform(s), software, hardware and/or architectures, without limitation.

In some embodiments, a user may redeem or otherwise utilize redemption information by “re-gifting” a redemption code to a participating entity 65 (e.g., vendor, merchant, selling entity, organization, or the like), for example, by providing redemption information, such as a code, and the participating entity's electronic address, to the system, in an electronic communication to the system. As may be appreciated from the drawings and this disclosure, a “re-gift” command may not be necessary, and some preferred embodiments may only require a recipient electronic address and redemption information. For example, in some non-limiting embodiments, the electronic address may comprise a userID, phone number, long number, short code, email address, social media profile number or ID, screen name, short number, a short string of characters which may be alphanumeric in nature, a vanity address (e.g., “Lowes”, “Arbys”, or “Walmart”), a trademark, or a portion of a trademark which may be recognized by the system and associated with an account or profile in a system-integrated database, without limitation. As will be seen in the appended drawings and appreciated by code produced in related applications, though capitalized herein to denote a third-party trademark, vanity addresses disclosed herein need not necessarily be used in a case-sensitive manner when providing them to the system in electronic communications/submissions. According to some embodiments, the electronic address (e.g., system-recognized vanity address) may incorporate a particular store location number (e.g., “Lowes58”, “Arbys217”, or “Walmart0317”). According to some embodiments, the system may recognize an incoming recipient electronic address as a participating entity 65 that is “redeem only”. In this regard, the system may void redemption information contained within or associated with an electronic system communication, may automatically credit the participating entity's account balance (e.g., the redeeming store), and/or may send a receipt, invoice, or statement via a physical or electronic communication means to the participating entity 65 in accordance with a system user agreement. In other words, in some embodiments, there may not be a need for separate “void” and “re-gift” commands as shown. For example, in instances where a recipient electronic address (e.g., contained within an electronic communication to the system, and/or which may an originating address of an electronic communication sent to and received by the system) is identified from a system-integrated database as a “redeem only” user using system software, a communication comprising a “re-gift” command and redemption information may be sent to a system electronic address in order to functionally request a “void” function to be performed by the system for the entity affiliated with the “redeem only” electronic address. In some embodiments, when cashiers (e.g., employee(s) of a participating entity(ies)) check out at the end of a shift, they may tally register counts against a real-time updated list of system transactions made during a particular time interval. In some non-limiting embodiments, a system API may be utilized to integrate the system (e.g., hardware and/or software components) with the participating entity's hardware, software, third-party software, scripts, payment terminal software, server computer, register system, payment service provider, etc. In some non-limiting embodiments, an API of the participating entity 65 may be utilized to integrate the participating entity (e.g., hardware and/or software components thereof) with system components (e.g., hardware, software, scripts provided on the system's server, without limitation), for example, to facilitate seamless integration of both system features and functions, and features and functions of the participating entity 65, its affiliates, and/or its third-party equipment and devices.

In some instances, electronic mail protocols (i.e., “email”, “webmail”, POP3, IMAP, SMTP, or the like) may be used as a platform to send redemption information pertaining to one or more items, products, goods, or services, to one or more recipients, including, but not limited to, the requesting user him/herself, and/or one or more contacts, connections, acquaintances, friends, family, or co-workers thereof. For example, in some embodiments, a requesting user may request a one-time pass code in an email communication to a system electronic address (e.g., a system email address such as “request@send1now.com”), via the same platform (email), or via another platform (e.g., social media, SMS, MMS, phone call, mobile messaging, website (e.g., web-form submission request), or the like). The request may comprise, for instance, a system-recognized command, text-based instruction, file attachment, or the like, which would be recognized by system algorithms and/or parsing software/scripts upon receipt. For example, the request instruction may contain a specified string or strings of predetermined alphanumeric and/or character-based text of any length. In the non-limiting embodiments shown, the text may comprise the number “1” placed in the subject field of the email communication. It should be appreciated that in some embodiments, a permanent or semi-permanent pass code (e.g., PIN, confirmation number, system card number, security code, passphrase, user assigned password, user defined password, or the like) may be used in lieu of, or in addition to, a one-time pass code, and the inventor contemplated and developed an early working prototype of this nature. In some embodiments, an email may be delivered by the system to the requesting user, for example, by virtue of a system script (e.g., PHP) and/or other code, without limitation, the email containing the one-time pass code. The one-time pass code contained in the response email may be provided in the subject line or other field (e.g., body) of the email. In some embodiments, the email received, may be replied to, for example leaving the one-time pass code in the reply email. Or a new email addressed to a system electronic address may be created by the user, wherein the user may copy and paste the received one-time pass code into one or more fields of the new email. An amount of credit to be sent, one or more UPC codes, and/or one or more system item codes (e.g., “hashtags”) may be provided in the subject line and/or body of the reply email, without limitation. In some embodiments, the particular placement location, spacing, and/or order of the provided amount of credit to be sent, one or more UPC codes, and/or one or more system item codes within the reply email may be a matter of preference only and may be properly interpreted by robust server-side system parsing algorithms. In some embodiments, the particular placement location, spacing, and/or order of the provided amount of credit to be sent, one or more UPC codes, and/or one or more system item codes within the reply email may be predetermined, for example, according to a set of rules or instructions provided by the system in the email or via other channels (e.g., the system website). The inventor has provided at least one non-limiting working embodiment wherein, for the sake of simplicity, the subject field may be parsed to identify the one-time pass code and/or the amount/UPC code(s)/system item code(s) associated with an item(s), product(s), good(s), or service(s) to be sent to a recipient(s), and the body may be left for a convenient message for the recipient(s). In the at least one non-limiting working embodiment, the one-time pass code appears first in order, followed by the amount/UPC code(s)/system item code(s). However, any permutation or combination of placement locations, spacings, or orders can be used as suggested by the drawings and in the aforementioned co-pending applications. For example, in some embodiments, the one-time pass code could be included in the body of the email and may optionally be provided in both of the body and subject fields. The various email portions may be parsed together, separately, or individually, by the system, using algorithms, for example, algorithms which may be used to verify the user's identity, mitigate vulnerabilities like SQL injection, avoid email-spoofing to the system (e.g., header file analysis and/or filtering), and/or to authenticate the validity of a transaction request made to the system via electronic mail. Parsing algorithms may be employed, e.g., provided within in scripts (e.g., PHP or other programming language) stored on a system-integrated server, in order to identify the particular one or more items, products, goods, or services (and/or amount of credit or funds) to be sent, based upon the received UPC code(s)/system item code(s). One or more recipient electronic addresses (including mobile phone number equivalent email addresses) may be provided in the “To:”, “Cc:”, and/or “Bcc:” fields of the email containing the one-time pass code and amount/UPC code(s)/system item code(s). The parsing algorithms may conveniently eliminate duplicate/redundant electronic addresses from one or more of the “To:”, “Cc:”, and/or “Bcc:” fields. In one preferred embodiment successfully actually reduced to practice, and shown in the figures, one or more recipient electronic addresses may be placed in the “Cc:” field. However, it should also be readily appreciated from this disclosure, and the disclosure of co-pending applications, that the “To:” field may be swapped with the “Cc:” field, for example, in such a manner that the recipients may be listed in the “To:” field, and the system electronic address may be listed in the “Cc:” field. Moreover, in some embodiments, the system electronic address and the electronic address(es) of an intended recipient(s) may all be included in the same field or fields. For example, the system electronic address and some or all of the recipient electronic addresses may be placed in the “To:” field. For example, the system electronic address and some or all of the recipient electronic addresses may be placed in the “Cc:” field. For example, the system electronic address and some or all of the recipient electronic addresses may be placed in both of the “To:” and “Cc:” fields. Such is more a matter of preference, convenience, and/or convention, but the inventor has deemed the best mode to be what is shown in the appended figures; wherein the system electronic address is placed in the “To:” field, and all recipient electronic addresses are placed in the “Cc:” field. As stated, it is envisaged that recipient electronic addresses and/or system electronic addresses may be present in either or both “Cc:” and “To:” fields, in various combinations and permutations, without limitation. In some embodiments, a mailing list containing a specified group or number of electronic addresses may be utilized in similar fashion.

In some embodiments, requesting users may provide one or more of their own electronic address(es) as an indicated “recipient” electronic address, for example, if they, themselves, wish to purchase one or more items, products, goods, or services, and receive redemption information regarding the same to one or more of their electronic addresses, using the system; for example, via an electronic communication to a system electronic address. According to some preferred embodiments, the communication to the system may be made, delivered, and/or received on, through, or using any one or more of the platforms mentioned herein or in the aforementioned co-pending applications. According to some embodiments, employed system algorithms may check a system-integrated database to determine if different recipient electronic addresses are linked to a common user (e.g., system user profile or account). In this regard, redundancies may be eliminated by system software (e.g., unbeknownst to the requesting user, or as a convenient safeguard to the requesting user), the requesting user may be assured that a recipient will receive redemption information (e.g., if one or more of the recipient electronic addresses may be discontinued, old, or not up-to-date), the requesting user may only be debited once per “user”, and/or similar redemption information may be provided to each of the duplicative/redundant electronic addresses.

In some embodiments, one, some, or all of the inventive features, concepts, steps, functions, and executions described in this and co-pending applications may be performed using system credit, non-system credit (e.g., other currencies including cryptocurrencies or the like), funds associated with a third party account (e.g., bank account, debit card account, credit card account, membership rewards account, loyalty account, rewards points account, accrued sky miles, store-credit, third party payment service credit (e.g., PayPal, Amazon), participating entity account, participating vendor/merchant/organization-recognized credit, or the like), without limitation; for example, to pre-pay for items, products, goods, or services and deliver redemption information regarding the same, to others, via one or more communications to the system. As will be appreciated from this disclosure, the one or more communications to the system may be performed by virtually all ubiquitous platforms (e.g., text, email, phone, web, and/or social media).

Embodiments of a system may comprise means for wirelessly transferring one or more funds or credits, or types 72 of funds or credits, including, but not limited to: coupons, gift cards, vouchers, offers, currency, pre-paid minutes, passes, tickets, codes, points, check information, currency, credit card information (e.g., receipt information), combinations thereof, etc., to a wired or wireless-enabled mobile device (e.g., a “dumb” mobile phone, a smart phone, a “wearable” computer, a tablet, a gaming device, a portable or non-portable television, a vehicular command system (i.e., “connected car computing device”), a set-top box, a laptop, etc.). Various non-exhaustive, non-limiting method steps which may be used to purchase and/or optionally load a system card 100, 200, 300, 400 with funds or credits, are shown and described.

According to some embodiments, a user of the system may purchase a system card at a participating entity 65. The system card may initially be deactivated (e.g., in a “NULL” status or “inactive” status) and may be provided to a gift card display rack at the participating entity. The system card may be changed to a semi-active status upon activation through a payment terminal of the participating entity 65 as conventionally done for gift card processing service companies (e.g., Blackhawk Network, InComm, etc.). According to some embodiments, a deactivated card may comprise an activation code, which, when activated from a semi-active status, may be associated/affiliated with a user's electronic address (e.g., mobile device number, mobile phone number, unique SIM card identification number, email address, social media profile, screen name, user ID, etc., without limitation) in a system-integrated database (e.g., system database 129 and/or third-party database 137, 138 without limitation), in various manners.

According to some embodiments, a user may purchase a system card at a point of sale (P-O-S) terminal, for example, at a register or checkout of a participating entity 65 as conventionally done for gift cards and other prepaid cards. According to some embodiments, a user 91, 92 may approach the checkout and instruct a checkout clerk that the user 91, 92 wishes to purchase the card itself (without funds or credits), and/or whether the user wishes to add funds or credits to the card. Once a user selection has been made, the user may provide payment data 10 (e.g., in the form of cash, credit card, debit card, gift card, points, system-based credits, cryptocurrency, etc.) to the checkout clerk using the appropriate conventional payment receiving means (e.g., cash register or EFT terminal provided to the checkout).

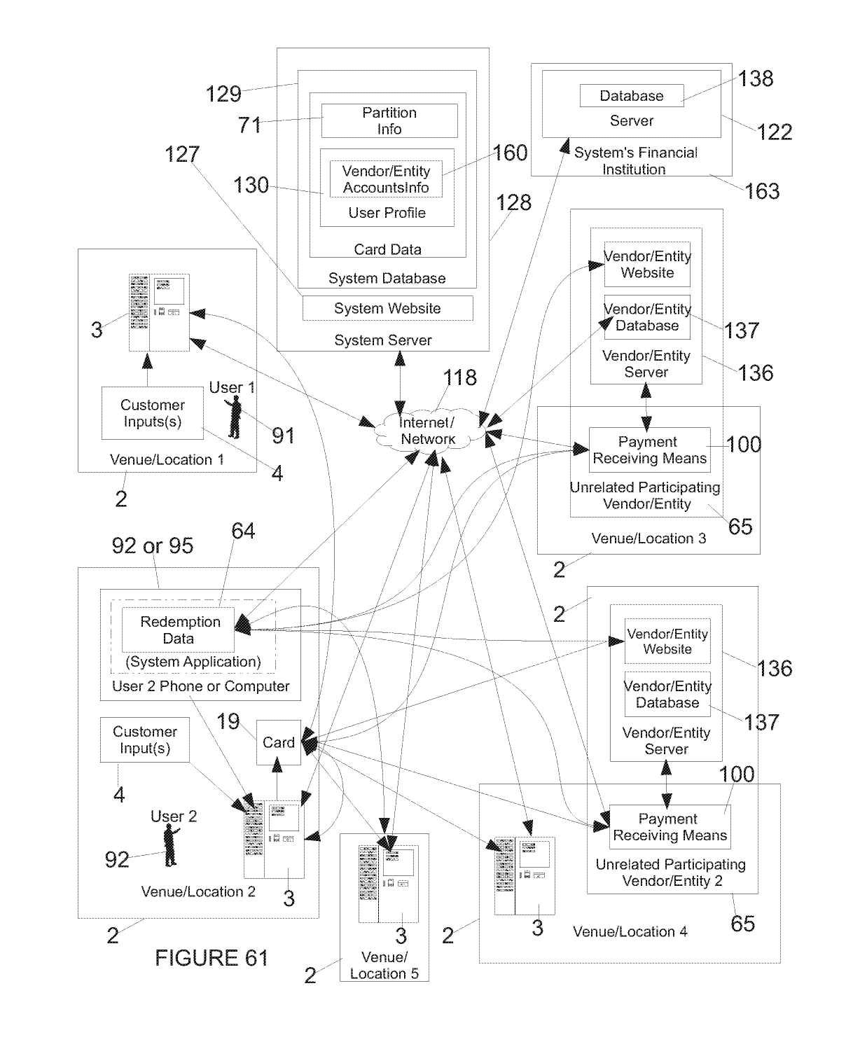

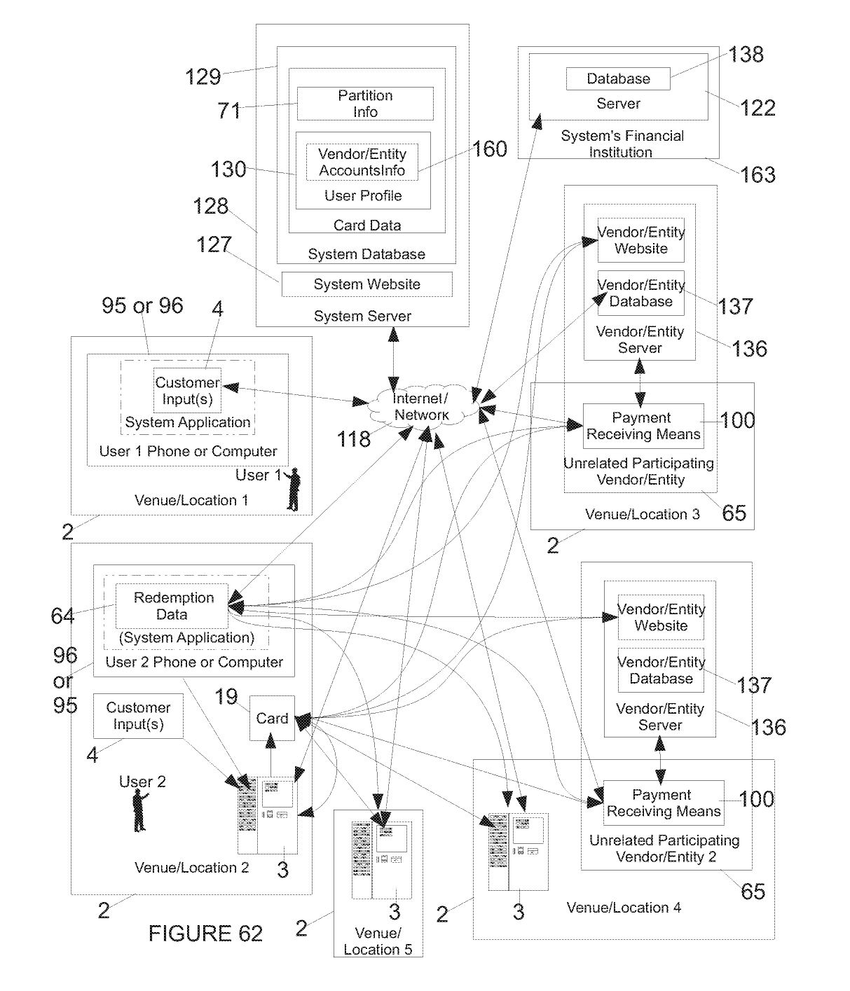

Optionally, a user 91, 92 of the system may provide one or more customer inputs to the checkout clerk, such as the mobile device number of the user 91, 92 who intends to use the card, or one or more other electronic addresses, without limitation. As will be described in more detail, similar customer inputs may be made to a system website (e.g., via a mobile device 96, computing device 95, cell phone, laptop, computer, gaming device, etc.); wherein user data 8 may not need to be provided to the checkout clerk at the time of purchasing/loading the card. For example, in some preferred embodiments, the user 91 activating the card may provide the one or more customer inputs 4 in private, for example, after the system card has been purchased and placed in a semi-active state. For example, the user may call a number provided on the card or card packaging to “activate” the card in a similar fashion to what is done for loading pre-paid phone minutes cards and credit cards, and may call a system number, listen to one or more provided system prompts (which may be automated), and respond to the one or more system prompts (e.g., “Welcome and congratulations on your new ShareCard purchase”, “press the pound key after making a selection . . . para Español, numero dos”, “Please enter or say your system card number”, “Please enter or say your system card PIN”, “Please say or enter the mobile device number of the user of this card”, “Please say or enter the activation code provided to your ShareCard”, “Please say or enter your email address”, “Please say or enter your facebook or Twitter profile account number”, “Please say or enter your physical address”, “Please say or enter your city and state”, “Are you finished, or would you like to link another electronic address to your card before activation is completed”, etc.). In other preferred embodiments, the user may text a number provided on the card or card packaging (e.g., a sticker applied to the card), using their own mobile device 96, to activate the card, and may respond to automated system prompts delivered from the system to the user 91 via text messaging protocols (e.g., “para Español, responde con numero dos”, “Please reply to this message with the system card number”, “Please enter mobile device number of the user of this card and reply”, “To confirm you will be the card user, please reply to this message with your mobile device number—that is the number you are using now”, “Please enter activation code and reply”, “Please enter your email address and reply”, “Please enter your facebook or Twitter profile account number and reply”, etc.). Other system-user prompts are envisaged which might seamlessly provide a complete, accurate, seamless, customized, and/or secure user experience with the system, its components, and/or inventive features and concepts thereof. The provided user data 8 may be used to auto-populate a system database 129 as shown in FIGS. 61-63b, for example, using computer software on a system server 128, without limitation. It is also anticipated that a physical person may receive and/or collect data provided in an electronic communication made to the system, including wireless or networked communications, phone “landlines”, or the like, and may manually enter the user data 8 and/or card data into the system database 129 using proprietary or third-party database interfaces. It is also anticipated that such card activation activities may be made using a system website 127, or system-integrated third-party website 136, such as a website supported by a financial institution that is integrated with the system.

System cards may be advantageously offered for purchase through kiosks, including system kiosks, or vending machines provided in plain view at a venue or location. The venue/location may be, for example, any convenient site, such as an entrance, foyer, or atrium of a mall, grocery store, airport, shopping plaza, public market, racetrack, or other convenient location, without restriction. Other examples of venues/locations where a card-dispensing kiosk may be positioned may comprise, without limitation, locations where other purchases are made, popular points-of-sale, retail stores, restaurants, parks, churches, gas stations, convenience stores, and/or pharmacies. The kiosks or vending machines may be placed separately from conventional checkout/registers, and therefore, they may be preferably configured to allow system cards to be purchased by users 91, 92 without secondary human interactions, particularly the aforementioned intervening human interactions which are conventionally required between a consumer and check-out clerk when purchasing or otherwise activating conventional gift cards, conducting money transfers, making wire transfers, making monetary exchanges, conducting stock/fund/financial asset trades, making redemptions, etc. According to some embodiments, kiosks may be card-dispensing kiosks or vending apparatus. Kiosks or vending apparatus may, via the Internet, wireless network, system client-host network, or equivalent network 118, allow purchase and/or activation activities to be completed through the kiosks or vending apparatus; for example, card activation activities for card-dispensing kiosks. According to embodiments where the system is provided with means for accessing profile accounts of third parties (through applications or website channels, such as social networking sites), friend information, such as electronic addresses of friends, contacts, relatives, co-workers, acquaintances, and/or other user data 8 may be auto-populated to the system database 129. Near frequency communication (NFC) technology or protocols may be utilized to perform the transfers or uploads of user data 8 to the system database 129. Audio data 7 may be provided as an input to system components.

Voice-recognition software may be implemented with system components; for example, to facilitate immediate user access to system information, account access, redemption data, and/or use of funds or credits associated with a system card 100, 200, 300, 400 or system account, without limitation. For example, in some embodiments, audio data 7 may be communicated through the system via system-integrated or non-system-integrated software (e.g., a speech-enabled dialing or speech-enabled texting mechanism installed on, pre-configured with, or otherwise provided to a user's mobile device 96, an optional mobile software application which may be downloaded to a user's mobile device 96). User data 8 provided to the system may be shared between system network components and/or “participating entities” (e.g., vendor/selling entities). For example, user data 8 may be shared between system servers 122, third party entity servers 136, financial institution servers 122, external servers 125, etc, without limitation.

According to some embodiments, two different users 91, 92 of the system may share or otherwise communicate audio data 7, such as audio-containing files, messages, text representative of an audio signal, videos containing audio, images representative of an audio signal, sound waves sent by attachment via email, sound waves sent and recorded in a voicemail/voice message, sound waves generated during a phone call, sound waves sent by attachment via SMS/MMS/mobile messaging protocols, sound waves generated during a web video or web audio call (e.g., Microsoft Link, Skype, etc.), through the system and/or through methods outside of the system, which may be used entirely as or as a portion of verification/authenticating/security means 44, 45, 60 for one or more particular transactions described herein. For example, if a non-user of the system receives a message containing redemption information 64 on their phone from a user of the system; for example, who sent an item or funds to the non-user, the non-user may call or text the sending user of the system, to verify that they received a transaction message, and/or learn that the transaction is legitimate, is coming from a trusted source, is valid, or is not spam. As another anticipated example, the non-user may listen to an attachment to the message comprising the redemption information created by the sending user of the system for similar purposes, without limitation.

It is anticipated that audio data 7 and/or image data 6 may be used in different manners to verify transaction authenticity or validity of redemption data 64 sent through various system delivery vehicles and electronic communications transmissions described herein (e.g., push/pull messaging). For example, a user possessing redemption data (e.g., on the user's mobile device 96 to be used at a point-of-sale at a participating entity 65) may be additionally prompted at the point-of-sale, for one or more security features, such as a verification code. At this time, a component of the system may automatically emit or relay (or prompt the user to manually select the option to emit or relay) auto-generated image data 6 (e.g., PIN, password, QR code, bar code, graphic, image) and/or audio data 7 (e.g., a real-time application-generated or stored and accessed electromagnetic signal; for example, one or more sound waves, radio waves, and/or digitone). For example, a system server 122 may be accessed from the mobile device 96 to relay, in an electronic communication, image data 6 and/or audio data 7 to the user's mobile device 96 via a system application 147 installed on the user's mobile device 96. For example, image data 6 and/or audio data 7 provided on the user's mobile device 96 (e.g., contained within an MMS message received from/delivered by a system component, or displayed/emitted from an optional downloadable system mobile application 147 running on the user's mobile device 96) may be delivered to and received by participating entity personnel (e.g., by being displayed, simultaneously played, delay played, or observed) and/or delivered to and received by the participating entity's payment system-supported/system-networked receiving means. The auto-generated image 6 or audio 7 data may be randomly generated by the system, for example, in much the same manner as secure SMS protocol is done for online banking (e.g., for one-time authorization (OTP) pass codes), without limitation.

A verification of a user's received image data 6 or audio data 7 may be performed by or using a participating entity's payment receiving means (e.g., a participating entity's payment terminal, or a system-supported/networked payment receiving means). In some embodiments, the system may electronically communicate image data 6 and/or audio data 7 information from the system server 128 to the participating entity's payment receiving means via a signal through the network 118, and the image data 6 and/or audio data 7 information received by the participating entity's payment receiving means may be stored in temporary or permanent memory of the participating entity's payment receiving means. The image data 6 and/or audio data 7 information received may be accessed by software provided to the participating entity's payment receiving means (e.g., a system application 147 or component thereof, a third-party or financial institution software application or component thereof, and/or a combination thereof). The participating entity's payment receiving means may emit image data 6 (e.g., from a display connected to a payment terminal) and/or audio data 7 (e.g., from a speaker or sound-emitting device connected to a payment terminal) for review by a checkout employee; for example, to compare it with image data 6 and/or audio data 7 provided to the checkout employee by the user, via the user's mobile device 96. In some embodiments, algorithms may be provided with the software provided to the participating entity's payment receiving means, wherein the algorithms may determine there is a match between the user's image 6 and/or audio-based data 7 and the image and/or audio-based data received by the payment receiving means via the system. If a match exists, then redemption data 64 may be authenticated, validated, voided, and the transaction may be completed. In this regard, redemption data 64 may, in some embodiments, be stored in a benign or “dumb” format (e.g., descriptive in nature of the product/offering/service for redemption) until the exact time of desired use, wherein the “actual” redemption data may be sent to the holder of redemption data at the time of redemption with a participating entity. Accordingly, if a user's redemption data 64 is inadvertently lost or misappropriated, a transaction utilizing the lost or misappropriated redemption data 64 may not be able to be completed without the proper user's mobile device 96. As suggested in the drawings, a user 91, 92 may, in some embodiments, redeem redemption information at the time of redemption by selecting a “redeem now” icon when the application 147 is displaying the relevant redemption information (e.g., which may be selected from a list of unclaimed “redemptions”). In some embodiments, a user may redeem redemption information at the time of redemption by speaking a command suggestive of a “redeem” function to a system integrated application 147, for example, when the application 147 is displaying the relevant redemption information. In some embodiments, a user 91, 92 may send an electronic communication (e.g., an SMS message or MMS message to a system electronic address, or a mobile message made through a system application 147, or an email to a system electronic address) to receive actual redemption information 64 from the system database 129 via the system server 128, at the time of redemption. The received redemption information may then be provided to the checkout employee and/or provided to payment terminal hardware which is configured to receive and interpret the redemption information (e.g., image data 6 or audio data 7).

User data 8 may be delivered to a system component, by a user 91, 92, for populating the system database 129. The user data 8 may be delivered to a system component in many ways. For example, information relating to a user of the system may be provided to the system database 129 via a system website 127, via a system application 147 (e.g., desktop version, TV version, mobile version, etc.), or via a kiosk 3 which is networked with the system via network 118. Such user data 8 may comprise information relating to one or more of the following: names or name information 47 of purchaser(s) and/or recipient(s); electronic address information such as phone number(s) or phone information 53 (e.g., carrier, plan, usage information) of a purchaser(s) and/or recipient(s) and/or email address(es) or email information 49 of purchaser(s) and/or recipient(s); account number(s) or account information 48 of purchaser(s) and/or recipient(s) (e.g. one or more system account numbers or account numbers of a third party program or website such as a social networking site 93); address(es) or address information 54 (e.g., street information, residence number information, city information, state information, country information, county information, location information, hemisphere information, etc.) of purchaser(s) and/or recipient(s) such as home address information, place of business information, and/or legal/tax residence information; bank or credit card number(s) or bank or credit card information 55 (e.g., expiry date, financial institution/company information, account information, account use information, security code information, signature information) of purchaser(s) and/or recipient(s); shopper loyalty/club/rewards/membership number or account information 56 (e.g., entity information, “membership since” duration information, visit history information, past purchases information) of purchaser(s) and/or recipient(s); birth date or birth date information 50 of purchaser(s) and/or recipient(s) (e.g., century, decade, year, month, day, hour, second, hospital, location); driver's/professional/certification or other license number or license information 57 of purchaser(s) and/or recipient(s) (e.g., state, country, organ donor information); biological/biometric information 51 of purchaser(s) and/or recipient(s) (e.g., iris pattern information, fingerprint information, vein pattern information, hair color, eye color, height, ethnicity, weight, etc.); tax identification information 58 (e.g., social security number SSN, naturalization number, citizen identification number, etc.); passport information 52 of purchaser(s) and/or recipient(s) (e.g., passport number, date of expiry); identification card information 59 (e.g., alien residence card information, student ID card information, ID card number) of purchaser(s) and/or recipient(s); authentication/security information 60 of purchaser(s) and/or recipient(s) (e.g., password information, security key information, encryption key information, security token); personal data of the purchaser(s) in general, personal data of the recipient(s) in general; information 63 pertaining to preferences of purchaser(s) and/or recipient(s); combinations thereof; or the like, without limitation.

In preferred embodiments, a real-time transaction of funds or credits may be made between a first user 91 at a first location and a second user 92 at a second location. Purchase data 9, such as information relating to a particular purchase made by or intended to be made by a user 91, 92 of the system may be entered or otherwise included as part of customer inputs 4. In some embodiments, “intended to be made by a user” may comprise information relating to shopping list 144, such as a “wish list” or “gift list”, associated with a user profile 130, 130′. Purchase data 9 may relate to funds or credits discussed throughout this description, and/or a particular unique system-recognized item number associated with an item, product, good, or service which is desired to be “LIKED”, recommended, bought, sold, and/or bought and sent to another (e.g., “gifted”). Redemption data 64, such as information relating to a particular redemption of an item, product, good, or service made by or intended to be made by a user 91, 92 of the system may be entered or otherwise included as part of customer inputs 4. Redemption data 64 may relate types of funds or credits discussed throughout this description (e.g., payment data 10), and/or a particular unique system-recognized item number associated with an item, product, good, or service which is desired to be “LIKED”, recommended, bought, sold, and/or bought and sent to another (e.g., “gifted”). Payment data 10 such as information relating to a form of funds or credit may be entered as customer inputs 4. Payment data 10 may comprise information relating to cash-based 10 currency e.g., cash, money, domestic currency, foreign currency, paper money, coin, legal tender, treasury note, money order). Payment data 10 may comprise information 12 relating to credit card credits (e.g., VISA, AMEX, DISCOVER, MASTERCARD, and/or other credit-based account information or data 55, including data stored on physical credit cards). Payment data 10 may comprise information 13 relating to debit card/electronic benefits transfer cards (e.g., debit card, welfare/benefits card EBT, electronic money, pre-paid cards, electronic funds transfer EFT card, bank card, or information relating thereto, including data stored on physical cards). Payment data 10 may comprise information 114 relating to checks (e.g., personal check, cashier's check, bank check, corporate check, payroll check, tax refund check, corporate check, bank account number, routing number, check number, etc.), including data stored on physical checks. Payment data 10 may comprise information 15 relating to gift cards (e.g., a gift card purchased online, a gift card bought at store, a gift card provided by third party, a physical gift card, an electronic “eGift” card), vouchers, rain checks, vendor-accepted funds or credit, store credit, gift certificate, eGift certificate, system account card, a kiosk-manufactured card, a kiosk-purchased card, transferable or purchasable rewards/loyalty points, transferable or purchasable frequent flyer miles, or the like, without limitation.

Payment data 10, purchase data 9, and/or redemption data 64 may comprise information 16 relating to a coupon or code (e.g., coupon information, code, alphanumeric code, character-based code, bar code, audio-based code, image-based code, indicia associated with a discount, group discount coupon information, participating entity-accepted funds or credit, sale code, savings code, online coupon code, promotional deal “promo” code, authorization code, or the like, without limitation). Payment data 10 may comprise information regarding frequent flyer miles. Payment data 10 may comprise information 17 relating to an account number 48 (e.g., bank account number, frequent shopper account number 56, membership account number, credit card number, system user account number, financial assistance account number, account number rewards account number, customer account, escrow service account number, payment system or service account number (e.g., PayPal, merchant account, acquiring bank account number). Payment data 10 may comprise information 18 relating to digital or electronic currency (e.g., Bitcoin, cryptocurrency, digital gold/DGC currency, etc.), as well as tradable asset or money market information 81 (e.g., stocks, mutual funds, and the like), without limitation.

After customer inputs are received by the system, one or more outputs 5 may be produced and/or delivered. According to some embodiments, outputs 5 may comprise one or more output functions and/or executions which may be performed. Outputs 5 may include one or more actions facilitated through mobile device communications, without limitation. For example, one or more of the outputs 5 may be produced, delivered, executed, and/or performed immediately upon user interaction with a mobile device 96, and/or one or more of the outputs 5 may be produced, delivered, executed, or performed at a later time after user interaction, for example, depending on system traffic over the network 118 and/or server 128 capacity (e.g., “store-and-forward” mechanisms provided to a system SMSC) or machine component limitations/capacities. According to some embodiments, one or more outputs 5 may be produced and/or delivered to a first user 91 (e.g., “purchaser” or “purchasing” user, or “sending” user), and/or one or more of the outputs 5 may be produced and/or delivered to a second user 92 (e.g., “recipient” or “receiving” user), upon various interactions between users 91, 92 and system components, including electronic communications between users 91, 92 and system components. For example, one or more outputs 5 may include distributing, receiving, accessing, and/or storing information pertaining to a card 19, without limitation. The information pertaining to a card 19 may be used during various transactions, shopping interactions, redemptions, and/or payments with/through/to/from a variety of vendors or entities 65, without limitation. The information pertaining to a card 19 may be accessed and re-accessed in a variety of manners, for example, via a system website 127, software application 147, computer 95, mobile device 96, system-integrated kiosk 3, or via use of the system-integrated card 19 at a participating entity 65 or online marketplace, such as a third-party participating entity website.

According to some embodiments, system-integrated cards 19 produced for the system, produced by system components (e.g., kiosks 3), used with or within the system, used with, within, or between system components, and/or provided through the system to system users 91, 92 may comprise a number of different types of cards (e.g., open loop/network card, closed loop card, hybrid closed loop card, rebate card, Mags Pangilinan-type cash card, restricted monetary equivalent card, scrip card, pre-paid card, pre-paid phone card, gift card, bank-issued gift card, credit card company-issued gift card, integrated circuit ICC card, smart card, RFID card, contactless card, magnetic stripe/magstripe card, electronic card, embossed card, printed card, paper-based card with machine-readable indicia and/or magstripe, keycard, access card, badge card, proximity card, stored-value card, security card, credential card, common access card, CR80.30 Composite PVC-PET card, high coercivity magnetic stripe PVC card, CR80.13 mil graphic quality PVC card, low frequency (LF) RFID card (e.g., 125 kHz, 26, 34, 35, 36 & 37-bit formats), high frequency RFID card (e.g., 13.56 MHz MiFare ultralight, 1K, 4K, Desfire, etc.), ultra high frequency card (e.g., 840 to 960 MHz), MiFARE card (e.g., 4K, 1K, mini cards), ultralight and ultralight C RFID key card, EM4100/EM4102 system-supported card, BLANK NXP MiFare RFID card, chip card, ISO 7816-compliant contact card, multicomponent card, memory card, CPU/MPU cards, vault card, fingerprint card, fingerprint information-containing card, dual interface card, 12 mil plastic card, 30 mil plastic card, plant-based card (e.g., by Ingeo), and/or combinations thereof), without limitation. In some preferred embodiments, cards 19 described herein may include one or more smart communication features which are broadly compatible with a variety of commonly-implemented vendor payment systems or well-established protocols. Other preferred embodiments may include PVC or similar plastic cards which are commonly used for financial transactions, identification, badges, key cards, and the like; however, it is envisaged that functionally-equivalent cards may comprise paper-based products such as cardboard or paper sheet which may or may not be backed, for example, with magnetic tape, stickers, and/or machine-readable indicia. Some or all portions of card surfaces may be matte in finish, glossy, and/or combinations thereof, without limitation. Cards 19 discussed herein may comprise, or have applied thereon, one or more stickers, for example, conventional graphic stickers, scratch-and-sniff stickers, stickers comprising image data 6 (including machine-readable indicia), and/or stickers having one or more appliable “scratch-off” portions or layers, without limitation. For example, a clear sticker may comprise one or more portions or surfaces which contain one or more removable masking layers applied thereon. In some embodiments, “scratch-off” means, card packaging, or one or more removable opaque devices may temporarily conceal indicia provided to a card (e.g., may conceal one or more function codes, security codes, activation codes, PIN information, machine-readable indicia, image data 6, and/or the like); for example, temporarily conceal indicia when a card comprises a “deactivated” state, an “un-purchased” state prior to a card being purchased, and/or a “semi-active” status after being purchased prior to activation. For example, in some embodiments, a front and/or rear portion of a card 19 may comprise one or more account numbers, PINs, function codes, instructions, text, images, machine-readable indicia, and/or other printed matter thereon, which may be temporarily covered by one or more films, layers, temporary peel off stickers, cardboard or plastic housings, wraps, etc., which may be opaque or substantially opaque in nature. In some embodiments, such components of a card may be covered by a clear sticker comprising a “scratch off”-type removable opaque material layer applied thereto; wherein, when the removable opaque material layer is removed by a user, it may expose an underlying card component. Stickers may be produced, and/or otherwise manufactured, provided, or dispensed from a kiosk 3. Stickers may be produced, dispensed, added to a card, and/or otherwise provided with a card during production of a card; for example, by a kiosk 3. In some embodiments, a user 91, 92 may add a produced sticker to an existing card 19, or to a card produced by the system via a kiosk 3.

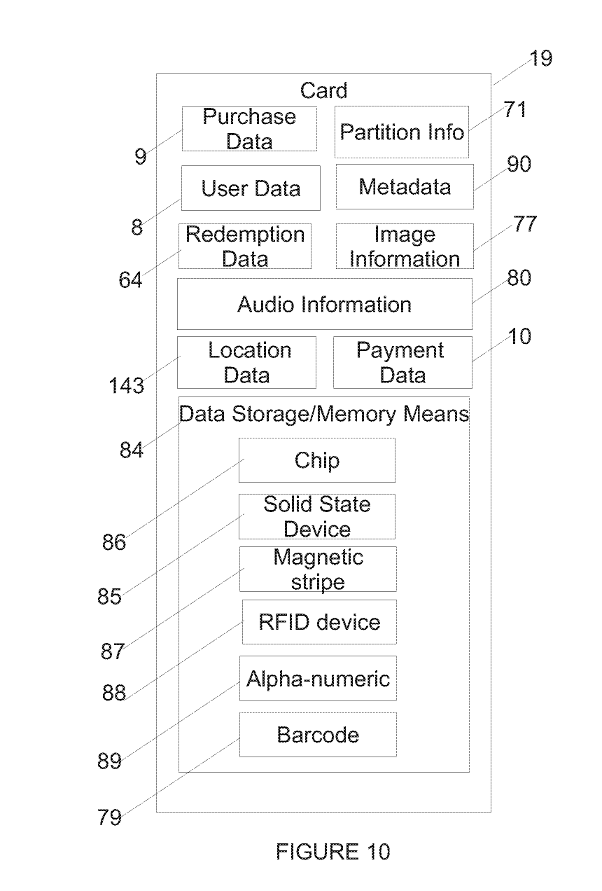

In some embodiments, a card 19 may comprise the form of a sticker (i.e., a “decal”); for example, to enable a card 19 to be permanently or semi-permanently affixed to an article. In some embodiments, a card 19 may comprise the form of a keychain apparatus (e.g., a “tag”, or “tang”, or “appendage” configured to secure to a key ring). In some embodiments, multiple cards of similar or different forms may be utilized to complete a transaction between two individuals or between a user and a participating entity. In some embodiments, a card may be pre-packaged in any quantity and sold by a participating entity 65. For example, a single card or a plurality of cards, each comprising similar or different machine-readable indicia, may be utilized as a component of the system, and may, for example, be packaged and/or sold by a participating entity 65, without limitation. In this regard, cards 19 may be configured to be physically applied to one or more physical articles or objects of a user to be used as a security feature (e.g., key, token, pass code, or combination thereof). Moreover, one or more cards 19 may be utilized as a security feature of one or more other cards 19 used to make a transaction. For example, according to some embodiments, one or more first cards 19 (e.g., in keychain and/or sticker form) may be scanned at payment receiving means of a participating entity (e.g., using reader means provided to a payment terminal) at the time of a transaction, in order to authorize and/or complete a payment transaction or redemption transaction; wherein the authorization step may further comprise the step of scanning and/or swiping a card 19 which is not the same as the one or more token cards; wherein the one or more token cards may be scanned prior to or after the step of scanning and/or swiping a card 19 which is not the same as the one or more cards scanned. In this regard, a transaction involving a card 19 may be authenticated using one or more additional security features in combination with, or in lieu of, an entered security PIN associated with a the card 19 as conventionally done with prior art cards. Moreover, in this regard, a transaction which might normally involve a first card 19 may be able to be performed in the absence of the first card 19, for example, by scanning the machine-readable indicia provided to the one or more second cards, using reader means provided to a participating entity terminal. It should be understood that various forms of cards 19 described herein are envisaged, and that various conceivable permutations of card contents and/or components may exist, without limitation. For example, a card 19 in the form of a keychain apparatus may comprise any of the card features, devices, or components described herein (e.g., memory, chip 86, magstripe 87, image data 6, audio data 7, image information 77, audio information 80, data storage means 84, and/or other component suggested in FIG. 10), without limitation.

According to some embodiments, similar interactions, steps, and functions may be practiced while shopping on a website using a mobile device 96 or computing device 95 capable of communicating with a system-integrated server 128. The website may be, for example, a checkout page of a website. For example, in some embodiments, one or more cards 19 may be scanned by a mobile device 96 or computing device 95 using, for example, image capture software and camera device operably connected to the mobile device 96 or computing device 95. In addition to scanning the one or more cards 19, in some embodiments, account information may be provided (e.g., to one or more input fields displayed on a browser of the mobile device 96 or computing device 95 which is displaying a webpage of the website). In some embodiments, software integrated with the system and installed on the mobile device 96 or computing device 95 may decode and/or decrypt the scanned machine-readable indicia, process information associated with the scanned machine-readable indicia, and use the processed information during an authentication step as part of completing an online transaction; wherein the authentication step may involve, without limitation, any one or more of the following steps: the webpage providing a prompt asking a user of the a mobile device 96 or computing device 95 to scan machine-readable indicia provided to the one or more cards 19; the browser provided to the mobile device 96 or computing device 95 displaying the webpage prompt; a user of the mobile device 96 or computing device 95 complying with the prompt by scanning the necessary one or more cards 19 using the camera of the mobile device 96 or computing device 95; software integrated with the system and installed on the mobile device 96 or computing device 95 receiving image data information associated with the one or more cards 19 which has been obtained by scanning the necessary one or more cards 19 with the a mobile device 96 or computing device 95; the software integrated with the system and installed on the mobile device 96 or computing device 95 decoding and/or decrypting the received image data information; the software integrated with the system and installed on the mobile device 96 or computing device 95 processing the decoded and/or decrypted image data information into a usable electronic format (“processed data”); the software integrated with the system and installed on the mobile device 96 or computing device 95 providing the processed data as one or more inputs to the webpage displayed by the browser (e.g., via an input field or other interface); the user submitting the processed data to the website hosting server (e.g., by pressing an HTML-based ‘submit’ button on the webpage); the website hosting server establishing a communication with a system-integrated server to access a system-integrated database 122, 128, 136; the website hosting server delivering the processed data to the system-integrated server in a communication to the system-integrated server along with information regarding the transaction amount (e.g., POST); the system-integrated server accessing a system-integrated database 122, 128, 136 and retrieving profile information associated with a profile 130 of a user 91, 92 of the mobile device 96 or computing device 95 (e.g., based on the processed data information received from the website hosting server); a script mechanism provided to the system-integrated server retrieving account balance information associated with the retrieved profile information; the script mechanism checking the account balance information against the information regarding the transaction amount and determining if there are sufficient funds to complete the transaction; wherein if there are sufficient funds, the script mechanism may: debit an account balance associated with the retrieved profile information, trigger a confirmation communication to the website host server, and/or credit an account associated with a profile 130 of the participating entity 65 affiliated with the website. In this regard, after receiving the confirmation communication from the system-integrated server, the website host server may deliver a confirmation webpage to the user of the mobile device 96 or computing device 95, via the browser, thereby completing the online transaction. According to some embodiments, the website may be a third-party website or a system website 127 (including, but not limited to a checkout page, redemption page, login page, a financial institution website, or the like), which may be integrated with system software and/or other system component(s) such as system instructions to be displayed on a browser, a system plug-in, a system add-on, a system API, or a module which may communicate with a system-integrated server 128, without limitation.

According to some embodiments, at the time of payment (e.g., at checkout), a user 91, 92 or checkout employee may similarly scan one or more cards 19 with payment receiving means located at a location/venue 2 of a participating entity 65, in a similar manner as described above. Other security protocols may be utilized, wherein audio data 7, image data 6, and/or various other electromagnetic signals including, but not limited to radio waves, sound waves (of one or more predetermined or variable frequencies) and optical signals may be emitted from a mobile device 96 or a card 19 to authorize a payment transaction in a similar manner, wherein the payment terminal software may comprise a browser or specialized user interface.

A system sticker may, in some embodiments, be applied to a paper product, a ticket, a pass, a receipt, and/or any other physical article, such as a user's mobile device 96, computing device 95, or vehicle. In some embodiments, a system sticker may be applied to items dispensed from a system kiosk 3. In some embodiments, information and/or indicia which may be provided to purchasable system cards, may be deliverable via a system website 127, wherein a confirmation webpage or electronic receipt generated from a website transaction may contain card information and/or indicia which can be printed by a user 91, 92 and kept in a wallet or purse, or taped to a mobile device or mobile device protective case. In other anticipated embodiments, electronic receipts delivered may be stored on a user's mobile device 96 and accessed and displayed each time the user wishes to make a transaction with the card information and/or indicia. The information/indicia may be used similarly to a system card and/or may serve as a “virtual” system card. For example, card purchases may be made using conventional EFT payment terminals already used in commerce by entering their virtual system card account number using a keypad, and/or, by scanning the indicia. Alternatively, a point of sale (P-O-S) clerk may need to manually enter the virtual system card account number, and/or scan indicia. In some embodiments, a user may add virtual system card information to his, her, or another user's “digital wallet” provided on a mobile device 96 in order to use existing NFC/tap to pay protocols and infrastructures.

Outputs 5 may include providing one or more receipts 20, e.g., via receipt delivery means, which may be delivered to a user 91, 92 (e.g., purchasing user, recipient user, repeat user, or new user) of the system in electronic form or physical form (e.g., via a kiosk 3 or payment terminal). For instance, receipts may be auto-stored electronically on a user's profile 130, 130′ in a system database 129 (e.g., in a user history) for convenient user and/or participating entity access and/or organization, while reducing negative environmental impacts and/or mitigating identification theft. Another output 5 may comprise a generated email and/or text message to a user's mobile device 96, for example, an auto-generated email sent to a mobile email address (e.g., for T-Mobile: <10digitphonenumber>@tmomail.net, for Virgin Mobile: <10digitphonenumber>@vmobl.com, for Cingular: <10digitphonenumber>@cingularme.com, for Sprint: 10digitphonenumber.@messaging.sprintpcs.com, for Verizon: <10digitphonenumber>@vtext.com, for Nextel: <10digitphonenumber>@messaging.nextel.com, for instance, +1 415-123-4567==>4151234567@txt.att.net). Outputs 5 may include other types of electronic message communications made to a properly-networked/supported device (e.g., caller identification display or cable/internet-based television systems comprising screen-displayed messaging technology). For example, delivery of an automated email message may be triggered upon a mobile device-facilitated purchase made by a user, and/or delivery of an automated email message may be triggered upon receiving one or more outputs 5 from or making one or more inputs 4 to the system using a system component (e.g., mobile device 96, computing device 95, or kiosk 3, system website 127, etc.). In some embodiments, an email 21 may be generated each time a system card 19 is used, wherein the email may contain information about the card's use (e.g., what was recommended, posted via a social network profile, purchased, transferred, etc.), thereby eliminating the need for a paper receipt, reducing exposures to identity theft, and/or simplifying digital records management, without limitation. In some embodiments, an email 21 may comprise one or more email. In some embodiments, one or more emails may be delivered to a mobile email address, for example, wherein an email may be received by a user's mobile device 96 and displayed or played (e.g., as a voice note and/or text message) on the user's mobile device 96. Outputs 5 resulting from system interactions with and/or between system components may include the delivery of one or more confirmation numbers or confirmation codes, such as an auto-generated code, to a mobile device 96, without limitation. A confirmation number or code may, for example, be used for one or more online or in-person transactions, as a PIN(s), to obtain one or more discounts, for verification purposes, for security purposes, for authentication purposes, and/or records retention purposes, without limitation. Outputs 5 resulting from interactions with the system, for example, interactions between users and system components and/or between system components, may comprise the composition, delivery, and/or receipt of one or more text or image-based messages 23, for example, via SMS/MMS-based messaging systems/protocols/platforms or equivalent mobile messaging means, such as through a mobile messaging application, without limitation. System components may parse information contained within a message and utilize the information in a plethora of manners described herein. Such messaging outputs 5 may be performed automatically, manually, or in accordance with one or more user preferences, and may provide a mechanism for paperless receipt. Outputs 5 resulting from interactions with the system, for example, interactions between users and system components and/or between system components, may comprise the composition, delivery, and/or receipt of one or more voicemail messages 24, including audio file-containing voicemail messages and/or “visual” voicemail messages. Voice messaging may be performed automatically, manually, or in accordance with one or more user preferences 63 contained within a server-integrated database 129. Outputs 5 from system interactions may, in some embodiments, comprise the composition, delivery, and/or receipt of one or more electronic messages to one or more electronic addresses. For example, an electronic message may comprise, without limitation, a fortune message, a greeting card message, a gift card message, a postcard message (e.g., “from ShareCard Hawaii, 8123567291 sends you a 24-pack (24×0.6 oz bite size) small jar of Mauna Loa chocolate-covered macadamia nuts (ShareCard ID# MLOANUT24PK) to 123 Apple St. Alexandria Va. 22314”), combinations thereof, and/or the like. In some embodiments, one or more components of the system may make one or more calculations regarding postage 26, may include postage in calculations, may subtract postage in calculations, may withdraw funds or credits to accommodate for postage, and/or credit a user profile 130 for postage received, without limitation. Postage calculations may be made using recipient electronic or physical address information provided as an input 4 by a user 91. For example, postage calculations for physical delivery of items may be calculated from information pertaining to a user profile 130. For example, calculations may be made by system software stored on a computing device, for items to be sent, sent items, and/or items purchased using system components. For example, a postage “value” or “amount” may be ascertained upon receipt of one or more item identification codes (e.g., “item codes”). The one or more item codes, may be received, for example, as a user-specified user input 4 (e.g., to a kiosk 3, website 122, or application 147, and/or in an electronic communication to the system via an electronic communications platform). Postage 26 may be fixed or otherwise predetermined for item codes, or may determined automatically by system algorithms contained in software, for example, by accessing profile 130 information. In some embodiments, profile 130 information may be accessed from a database 129. For example, using recipient electronic address information provided, system scripts supported by system computing devices may access one or more profiles 130 associated with the recipient electronic address information and determine one or more physical addresses of users 92 associated with the recipient electronic address information, from the one or more profiles 130. In some embodiments, postage 26 for multiple recipients may be calculated by a system component; wherein the postage 26 may be charged to and/or debited from a user's 91 account balance, for transactions involving more than one recipient. It should be understood that postage 26 may, in some embodiments, postage 26 may comprise delivery fees (e.g., food delivery, flower delivery, service fee, driver tip, door-to-door delivery fees, convenience fees, driver taxes, and/or the like), without limitation.

Electronic money currency 27 (e.g., electronic funds, digital credits, digital/electronic currency, domestic currency, foreign currency, legal tender, treasury note(s), money order information, electronic notes, cryptocurrency, etc.) may be delivered to a user of the system disclosed herein as an output 5. The currency 27 may, for example, be delivered to a user 91 as change for a purchase made through a system component. In some embodiments, the currency may be delivered to a user 92 as redemption information 64 (e.g., in the form of a gift from another user 91 of the system). Various combinations of the aforementioned are envisaged. According to some embodiments, a system output 5 may comprise one or more updates 142, which might include, for example, one or more updates 142 to a customer input(s) 4; one or more updates to information associated with one or more system accounts 48 (e.g., an intended recipients account, a purchasing user's account); one or more updates to one or more system-integrated website(s) 93, 127 (including, but not limited to possible third-party websites such as financial institution websites and/or participating entity websites); one or more updates 142 to one or more system-integrated database(s) 129, 137, 138; one or more updates to system-supported application software 147 or integrated third-party software, which may, in some embodiments, be used on a user's mobile device 96 or computing device 95 (including participating entity payment receiving means, such as a payment terminal, without limitation); one or more updates 142 to one or more financial institution database(s) 138 (e.g., which may be hosted by a financial institution server 122 or other server 125); one or more updates to one or more external institution databases 135 (e.g., hosted by one or more external servers 125 or “cloud” servers), one or more updates to one or more participating entity 65 databases 137 (e.g., hosted by one or more third-party server 136), one or more updates 142 to portions of one or more social media sites 93, one or more updates comprising electronic information being packaged, communicated/delivered to, and/or received by an advertising group, ad client or host, research firm, or the like 94; one or more updates to user data 8, profile 130, 130′ information, location data 143, payment data 10, purchase data 9, redemption data 64, and/or the like, without limitation.

Mobile devices 96 (as well as other components like kiosks 3, computing devices 95, payment receiving means, etc.) described herein may comprise Internet and/or other communication network connection means for communicating with other mobile devices 96a, 96b, other computing devices 95, other system components (e.g., system devices, system platforms, system SMS gateways, system SMSCs, system applications, third party applications), and/or other components of the system described herein which may be linked to or otherwise have means for communication access to the Internet and/or other communication network(s) 118 (e.g., 3G UMTS CDMA-based networks, 4G LTE OFDMA-based networks, TCP/IP internet protocol suite-based networks, Global System for Mobile Communications/GSM networks, Global Positioning System GPS networks, General Packet Radio Service/GPRS networks, cdmaOne networks, CDMA2000 networks, Evolution-Data Optimized/EV-DO networks, Enhanced Data Rates for GSM Evolution/EDGE networks, Universal Mobile Telecommunications System/UMTS networks, Digital Enhanced Cordless Telecommunications/DECT networks, Digital AMPS/IS-136/TDMA networks, Integrated Digital Enhanced Network/iDEN networks, Long-Term Evolution/LTE networks, High-Speed Downlink Packet Access/HSDPA networks, WiMAX networks, WCDMA networks, Internet Protocol Version 4/IPv4-based networks, Internet Protocol Version 6/IPv6-based networks, etc). Mobile devices 96 may facilitate many or most system operations and functions described herein, for example, such as receiving inputs 4 from a user(s) 91, 92, delivering one or more outputs 5, performing one or more updates 142, and/or facilitating transactions described herein in general, without limitation, as will be appreciated by those skilled in the art from this disclosure.

System components described herein may, according to some embodiments, be provided with security means (including redundant security means, without limitation). In some embodiments, security means may comprise or otherwise support one or more encryption/decryption tactics, functions, expressions, steps, executions, or outputs. Security means may, in some embodiments, comprise without limitation, authorization protocols, security algorithms, cryptographic/cryptologic algorithms, cryptosystems, plaintext to cipher-text encryption and/or decryption software, key/cipher-based protocols, secure code validation techniques known in the art, symmetric key cipher protocols, secure remote access/secure shell SSH client programs/network protocols and/or similar built-in architectures, transport layers, user authentication layers, connection layers, public key cryptography systems, RSA/DSA key exchanges, secure copy SCP protocols, FTP/SFTP transfer protocols, cryptographic hash functions, data encryption standard DES-compliant encryption algorithms, advanced encryption standard AES-compliant algorithms, public key infrastructures, modular multiplication/exponentiation means, Bitcoin client software (e.g., open source code used for security measures), P2P networking protocols, encoding schemes, digital wallet security features, block-chain accessing functions, digital currency exchange client software, various combinations thereof, or the like, without limitation.

Cards and/or other apparatus (e.g., mobile devices 96) described herein may be advantageously utilized with payment receiving means; for example, payment receiving means provided to system components (e.g., to a system-integrated server, a system-integrated website, a kiosk, system software, payment or “checkout” terminals of participating vendors/entities 65 (including brick and mortar locations 2 as well as participating entity websites and “online” environments) described herein, without limitation. In some embodiments, payment acceptance means may comprise software, hardware, and/or physical apparatus for accepting payments, funds, or credits of any sort. For example, payment receiving means 100 may comprise, for instance, one or more electronic funds transfer acceptance systems, currency acceptance mechanisms, electronic funds transfer or credit card acceptance devices, coupon code validation and/or acceptance software/hardware, gift card validation and/or acceptance software/hardware, credit/debit card acceptance terminals, electronic funds transfer/point-of-sale/EFT-POS terminals, hardware/software components of an EFT-POS terminal, magnetic stripe readers, EMV/VSDC/Mchip/AEIPS/Jsmart/D-PAS acceptance terminals, secure online payment submission web pages, secure checkout pages, digital wallet acceptance terminals, digital currency exchange client software, contactless payment systems, payment due calculating software/hardware, electronic payment software and/or hardware systems, credit adjusting software, account information updating software, payment software applications (including payment service software provided by the like PayPal or AMEX, without limitation), wireless or hard-wired smart phone swipe crediting systems (e.g., of the type marketed by Square, without limitation), mobile tap and go device or sticker systems (e.g., MasterCard PayPass, VISA PayWave), smart phone/digital device payment applications (e.g., Wells Fargo, Chase Bank, or Bank of America “app”), Near Field Communication (NFC)-compatible payment terminals, acoustic-based payment terminals, terminals comprising optical-input information readers, payment terminals configured to receive and decode various electromagnetic signals (such as radio waves/sound waves of one or more or varying frequencies), payment terminals comprising single or multi-wavelength light-emitting means, and/or various combinations thereof, without limitation.

Internet/network 118 connection means 101, which may be used by mobile devices 96 or computers 95 of users 91, 92, and/or other system components may comprise, without limitation, one or more Ethernet-compatible devices, wireless network (e.g., WAN) devices, LAN cables (e.g., of the category 5 RJ-45-type), LAN/WAN/GAN/3G/4G/LTE/LTE advanced compatible devices, IP network addresses, wired (e.g., Ethernet) or wireless (e.g., Wi-Fi-based) routing devices, routers (e.g., ADSL), fiber optic hubs, internet protocol suite TCP/IP-compatible devices, ISP-software/hardware, IP networking device, modem device (e.g., USB broadband, ADSL), local servers, hubs, ports, switches, network distributors, wire-enabled network cards (internal or external), peripheral component interconnect (PCI) connections, industry standard architecture (ISA) connections, wireless-enabled network cards/NIC (internal or external/USB), internet service providers (ISP), firewalls (e.g., built-in, hardware, or software-based), or the like. Various protocols within different electronic environments are envisaged as will be appreciated by those artisans skilled in the data communications arts.

Audio input means 103 may, in some non-limiting embodiments, be provided to mobile devices 96, 96a, 96b, computing devices 95, and/or other system components, such as a kiosk 3, a vehicle, a television, a checkout payment terminal comprising a CPU, etc., without limitation. For example, in some embodiments, mobile devices 96 and other system components used within the system to perform inventive concepts may comprise one or more microphones, VoIP-compatible devices and/or associated software, electromagnetic induction devices, acoustic-to-electric transducers, acoustic-to-electric sensors, piezoelectric devices, fiber optic devices, micro electrical-mechanical system (MEMS) devices, speaker devices, wireless audio devices, sound emitting diodes or diode devices, microphone interfaces, calibration means, audio/sound filters, wires, sound processing means, speech recognition software, language translation software, speech-to-text mechanisms, combinations thereof, and/or the like, without limitation.

According to some embodiments, a system application, and/or third-party software application offering system functionalities and/or advantages may be employed by components of the system; for example, to streamline a user interface, and/or present a more graphically user-friendly or convenient interface (e.g., GUI, HMI) for facilitating interactions with system users 91, 92. The system application may also facilitate inter-component actions, functions, and/or communications, without limitation. According to some non-limiting embodiments, a system-integrated application may comprise a mobile application for use with a mobile device 96. A mobile application, according to some embodiments, may comprise specialized features for facilitating specific system functions (e.g., more broadly generalized as a system mobile application, e.g., “send1” mobile application). A mobile application, according to some embodiments, may comprise a mobile application of a third party (e.g., a participating entity 65 mobile application); for example, a mobile application wherein any one or more of the system components, steps, features, or inventive concepts may be practiced utilizing the mobile application. In some embodiments, multiple mobile applications (e.g., of various types) may be associated with a system, without departing from the scope of this disclosure.

Any application and/or applications discussed herein (including portions of code contained in the aforementioned applications) may comprise, or may otherwise form a component or portion of a larger system application 147. The larger system application may, or may not be integrated with third-party software (e.g., interconnected computer code, modules, add-ons/ins, APIs, scripts, programs, etc). In some instances, an “application” or “applications” may comprise one or more third-party applications, including purely third-party applications, without limitation, wherein the “system” may, in some instances, be thought of as a “technology as a whole” and the various system methods, components, features, steps and/or elements disclosed herein may be employed or otherwise reduced to practice or executed by a third-party (e.g., participating entity 65 or legal entity not affiliated with the inventor/applicant). Third-party reductions to practice of commercially viable best modes of the inventive concepts using one or more combinations of elements or features disclosed herein are anticipated.

In some embodiments, a user interface 106 may be employed to various system components (e.g., a browser configured to display a webpage of a website). The user interface may comprise one or more of the following alone or in various combinations, without limitations: a graphical user interface GUI, a human machine interface HMI, a human-computer (HCI) interface, a man-machine (MMI) interface, a schemata device, a web-based user (WUI) interface, a touch screen, a control panel, a physical or tactile/touch-based keypad, a mouse/tracking ball/stylus/roller/joystick, a command line interface, a touch user interface, a haptic feedback mechanism, an attentive user interface, a batch interface, a conversational interface, a crossing-based interface, a gesture interface, an intelligent user interface, a motion tracking interface, a multi-screen interface, a non-command user interface, a canonical window system-based interface, an object-oriented user (OOUI) interface, a reflexive user interface, a tangible user interface, a task-focused interface, a text-based user (TUI) interface, windows, icons, menus, pointer interface (WIMP), a voice user interface, a natural-language interface, a zooming user interface, other mechanisms of an interface which allow a user to communicate with a system and/or provide one or more user inputs to the system to obtain a desired output, or the like. It is envisaged that an application(s) and/or components/portion of an application(s) disclosed herein may be employed with any capable component discussed herein (e.g., mobile devices 96, computing devices 95, kiosks 3, payment terminals, “connected” vehicle systems, and/or the like, without limitation).

Advertising means 107 (e.g., means for advertising) may be physically or electronically provided to various components associated with the system, such as one, some, or substantially all components of the system (e.g., including physical and/or electronic messages or communications created, delivered, and/or received between users). In some embodiments, advertising means 107 may comprise system indicia or other information pertaining to system features, steps, or elements. Advertising means 107 may be provided to system components, such as system-integrated kiosks 3, system-integrated website(s) 127, system-supported software (e.g., computer programs and/or mobile applications), to system cards 19, and/or to other types 72 of physical or digital articles (e.g., electronic or physical receipts, airline tickets, etc.). In some embodiments, peripheral advertising means 107 may be distributed throughout the system; for example, in public or private locations/venues 2. According to some embodiments, advertising means may comprise one or more of the following, without limitation: integrated marketing management software, customer insights and/or feedback processing software, qualitative algorithms, analytics software, customer relationship management CRM/SaaS software/systems, aggregate transaction information storage and access means, data collection software, B2C marketing automation tools/systems, inbound marketing automation tools/systems, search engine optimization (SEO) tools, social media marketing SMM applications, social software applications, marketing automation tools/systems, voice-based marketing automation (VBMA) applications/software platforms, lead generation software, lead tracking software, lead scoring software, lead routing software, lead nurturing software, lead reporting software, CRM integration systems, hosted interactive voice response software, API integration protocols, software analytics-enabled software, SMS/MMS messaging software and networking solutions, online advertising management platform components, adware/advertising-supported software, promotions, logos, offers, advertisements, subliminal imaging, pop-up ads, adware, suggestive marketing, targeted marketing tactics, browser advertising, advertisement software, ad-enabled browsers, ad-enabled search toolbars, keystroke monitoring software, and various combinations thereof, without limitation. Advertising means 107 may involve graphical information, audio information, video information, and other forms of media used to advertise items, products, goods, services, offerings, deals, incentives, promotions, rebates, discounts, and the like, without limitation.

Payment dispensing means 108 may be provided to system components, such as the system website 127, system server 128, system database 129, system software, and/or to participating vendors/entities (including participating entity websites and/or payment terminals) described herein, without limitation. Payment dispensing means 108 may comprise various combinations and/or permutations of software, hardware, firmware, and/or physical apparatus for disbursing, distributing, reallocating, refunding, or crediting payments, funds, or credits, and the like, as well as means for receiving, processing, redeeming, and/or voiding redemption information 64, without limitation. Payment dispensing means 108 may comprise, for instance, one or more physical payment dispensing devices, electronic payment delivering means, change calculating software/hardware, electronic payment/crediting software or systems, credit adjusting software, account information updating software, payment applications, wireless smart phone swipe crediting systems, mobile tap and go device sticker systems (e.g., MasterCard PayPass, VISA PayWave), smart phone/digital device payment applications (e.g., Wells Fargo or Bank of America app, electronic funds transfer delivery systems, currency conveyance mechanisms, electronic funds transfer or credit card crediting or transferring devices, coupon code validation software, coupon issuance/re-issuance software/hardware, gift card validation and issuance/re-issuance software/hardware, credit/debit card acceptance terminals, electronic funds transfer/point-of-sale/EFT-POS terminals, hardware/software components of an EFT-POS terminal, magnetic stripe writers/readers, EMV/VSDC/Mchip/AEIPS/Jsmart/D-PAS acceptance terminals, secure online payment submission web pages, secure checkout pages, digital wallet acceptance terminals, digital currency exchange client software, contactless payment systems, and various combinations thereof, without limitation. In some embodiments, payment receiving means and payment dispensing means 108 may share and/or comprise similar components, elements, or features.

In some embodiments, payment acceptance and/or dispensing functions may be directly or indirectly performed and/or controlled within a secure hosting location (e.g., on the system server 128), by at least one controller or other processing unit configured for running software containing various algorithms and/or software functional executables which manipulate data stored on or within the system database 129 or other system-integrated database 137, 138 (e.g., a MySQL database comprising one or more tables comprising user data 8 and/or profile 130 information). For example, such means may comprise computer code which is configured to subtract a first amount from a first user's 91 account balance 119, and add the first amount (or a percentage or portion thereof) to a second user's 92 account balance 119. The computer code may access, index through, and/or retrieve information as needed from a database 129, 137, 138; for example, based on inputs 4 received by a user 91; or automatically, for example by extracting or parsing communication metadata associated with an electronic communication made by or originating from a user's 91 mobile device. According to some embodiments, the metadata may comprise, for example, electronic address information of one or more requesting users 91 and/or one or more recipient users 92. Moreover, in some embodiments, the metadata may comprise information sent to, from, or transmitted through system components (e.g., to a system-integrated server 129, 137, 138) via a third party network, service, or application, without limitation.

System components, including, but not limited to mobile devices 96, computing devices 95, vendors/selling entities (i.e., “participating entities” 65), physical venues/locations 2 (e.g., a brick-and-mortar vendor/selling entity 65 facility), virtual venues/locations 2 (e.g., an online marketplace or website of a vendor/selling entity 65), etc., may comprise indicia or image-based information (e.g., “machine-readable indicia”), which may be read using reader means provided to other system components. The indicia or image-based information may be scanned, read, interpreted, and/or processed into a usable form of information (e.g., using a first system component). The processed information may be utilized by and between system components (e.g., including system components other than the first system component) in a variety of different ways. For example, in some embodiments, a step of scanning indicia or image-based information may be performed to send an electronic communication to and/or from a controller associated with one or more system-integrated servers which may be operably connected to one or more system-integrated databases. According to some non-limiting embodiments, indicia or image-based information may be scanned by a user of the system, in order to perform one or more functions; for example, to send one or more messages from one system component to another system component, to perform a “liking” function, to add something to a user's wish list, and the like. Messages sent between system components may comprise one or more pieces of textual or image-based data which may be usable by a user, for example, to redeem one or more items, products, goods, or services in exchange for or by providing one or more pieces of textual or image-based data to a participating entity 65. According to some non-limiting embodiments, indicia or image-based information may be scanned by a user of the system, in order to send one or more electronic communications, such one or more messages (e.g., request communications), to one or more system-integrated server controllers, or to other system components (e.g., indirectly to user mobile devices 96, via a system server 128). In some instances, the one or more messages may be text-based. In some embodiments, the one or more messages may comprise one or more of an SMS, MMS, mobile communication (e.g., mobile message), text message, a voicemail, an email, a social media post, various combinations thereof, or the like, without limitation. In some instances, POST data associated with one or more messages or communications made from a first system component may be received by another system component and used in the execution of a function or to complete a transaction. In some instances, electronic communications may comprise information which may be encrypted and/or coded and then decrypted and/or decoded by proprietary software algorithms during various steps. It should be understood that any practical or otherwise usable type of indicia or image-based information disclosed herein may be utilized, including text, which may be read using OCR or image capture means, without limitation. In some embodiments, visual-recognition technology may be employed. In some instances, one or more collaborative filtering (CF) techniques may be utilized with system-usable processed data obtained from indicia or image-based information.

Indicia or image-based information may, in some embodiments, be used in conjunction with information provided to cards 19 and/or user mobile devices 96 (which may or may not necessarily comprise system-supportive or system-based software applications), in order to perform various functions and transactions. The indicia or image-based information may comprise information regarding items, products, goods, or services, or data thereof (product data). For example, the indicia or image-based information may comprise, one or more markings, barcodes (both 1D and 2D), short codes, listings of short codes, item codes, listings of item codes, function codes, listings of function codes, or the like. The indicia or image-based information may be provided to smart RFID tags connected to items, products, or goods.

Items, products, goods, and/or services may employ the indicia or image-based information described. According to some embodiments, mobile devices 96, 96a, 96b and other system components (e.g., kiosk 3) may comprise an onboard database 128 and/or means 112 for accessing a system-integrated database, such as a system database 129 stored on a system host server 128. The means 112 for accessing a system-integrated database may, in some non-limiting embodiments, comprise mobile device 96 hardware and/or software which is sufficiently configured to enable user “texting” of one or more unique data retrieval codes provided to a card 19, to a system electronic address; for example through an SMS communication protocol. The means 112 for accessing a system-integrated database may enable a user to change profile 30 information associated with an electronic address; wherein the electronic address may comprise a mobile device number of a user 91, 92, particularly the mobile device 96 number of a user 91 making a request to the system. The one or more unique data retrieval codes provided to a card 19 may comprise an account number, without limitation. The one or more unique data retrieval codes provided to a card 19 may comprise function codes, without limitation. In some embodiments, the one or more unique data retrieval codes provided to a card 19 may be provided to one or more fields of a website page, in order to perform one or more functions using the card.

Databases 122, 125, 129, 136, 93, 94 utilized by system components may comprise one or more database management systems (DBMS), SQL-compliant devices, ODBC-compliant devices, JDBC-compliant devices, supporting database structures, database model(s), database servers, multitasking kernels, networking support modules, RAID disk arrays, XML models, application software, application programming interfaces, NoSQL/NewSQL databases, document-oriented databases, key value stores, in-memory databases, active databases, database triggers, cloud databases, data warehouses, deductive databases, distributed databases, document-oriented databases, embedded database systems, end-user databases, federated database systems, multi-databases, graph databases, triple-stores, network databases, hypertext databases, hypermedia databases, knowledge base databases, mobile databases, customer databases, parallel databases, shared memory architectures, shared disk architectures, shared nothing architectures, probabilistic databases, real-time databases, spatial database, temporal databases, terminology-oriented databases, object-oriented databases, unstructured data databases, and/or various combinations thereof, without limitation. According to some non-limiting embodiments, database access means 112 may comprise means for accessing one or more external databases 135 (e.g., those of social networks 93, advertising entities 94, or other large data or “big data” corporations), participating entity 65 databases, financial institution databases 138, and the like. Database access means 112 may be provided to the system website 127, system server 128, and/or system-integrated applications/software 147 and/or components thereof (e.g. a system mobile application).

Image data used by the system, including indicia and image-based information, may be provided to a kiosk, a website, a TV advertisement, a billboard, television, leaflet, pamphlet, brochure, magazine, newspaper, car wrap, product packaging, or other display, without limitation, as will be appreciated by the appended drawings. One or more scannable images may be provided to a system component, for example, a machine-readable image, a bar code (e.g., 1D, 2D, data matrix, or QR code), a graphic, printed matter, one or more codes, one or more alphanumeric strings, one or more item identification numbers, etc. The one or more scannable images may be provided to a system component in order to allow a user 91 to conveniently “import” an item code, for example, to an electronic message (e.g., SMS, MMS, or mobile message), or to a field of a system application or browser. Importing may be performed using scanning means such as an image capture device and relevant software provided to the user's 91 mobile device 96. During the step of importing, image data may be converted to text using software; for example, in some embodiments, after the step of scanning one or more scannable images, data contained within the indicia or image-based information may be processed into text or character-based data and/or imported into a relevant field (e.g., an email communication, an SMS/MMS/Mobile messaging communication, a social media post communication, etc.). The one or more scannable images may be provided to a system component in order to identify a particular redemption option (e.g., functions or transactions that can be performed with a particular item, product, good, or service which may be displayed as prompts which may be selectable upon user input 4). The one or more scannable images may be provided to a system component in order for a user 91 to learn of or understand an instruction to be performed. The one or more scannable images may be provided to a system component in order to assist a user with performing an action or specific function (e.g., a recommendation action (e.g., “share” or “recommend”), an action of providing a favorable opinion (e.g., “like”), a gifting function (e.g., “gift”), a purchasing function (e.g., “buy”), an ordering function, a delivery function, a function regarding adding something to a wish list (e.g., “wish”), a function regarding adding something to a gift list (e.g., “add”), a function regarding adding something to a shopping list function (e.g., “add”), or the like, without limitation). In some embodiments, each function may comprise its own scannable image. In some embodiments, a mobile system application 147 may present a number of function prompts or redemption options after scanning a single scannable image. In some embodiments, one or more scannable images may be attached as embedded or attached image files in one or more messages (e.g., of an MMS message or email) addressed to a system electronic address, wherein system software and hardware (for example, located a secure host location) may parse the received one or more messages, process the received image(s) contained within the received one or more messages, extract data contained within the received image(s), and/or perform one or more functions (e.g., execute a transaction or execute/complete a user-requested function), for example, based upon: 1) information provided in the one or more messages (e.g., one or more other commands or contents of the one or more messages without limitation), and/or 2) information contained within the image(s) of the one or more messages. This image data will readily be understood and/or appreciated from the appended drawings. Image data may comprise the form of one or more “character” or “text”-based images, such as images which may be “texted” from a mobile device 96, images which may be “texted” from an instant messaging application suitable for execution on a computing device 95, images which may be selected from a user's mobile application 147 or mobile device 96 memory (e.g., SIM, drive), and/or images which may be sent from (or received by) a mobile device 96 via SMS/MMS-based and similar mobile-messaging protocols. In some embodiments, image data may comprise one or more mobile device-taken images (e.g., images taken with cell phone, tablet, gaming device, PDA, digital camera, or portable computer). In some embodiments, image data may be displayed on a screen of, projected from, and/or emitted from a mobile device 96. In some embodiments, image data may be displayed proximate a payment terminal (e.g., a barcode scanner at a point-of-sale register or checkout camera reader). In some embodiments, image data may be inputted (e.g., via uploading) in a data entry field on a mobile application display page or website checkout page which may be displayed in a browser.

According to some embodiments, image data may comprise one or more images provided via email, for example, provided in an email sent to, received by, and/or delivered from a system electronic address, such as an email address. An emailed image may comprise, for example, an image accessed from memory of a mobile device 96 such as a cell phone, smart phone, tablet, PDA, gaming device, wearable, or portable computer. According to some embodiments of the system and/or components thereof, images and/or text correspondence may be delivered via internet email transmission protocol, multipart/mime message, base64 encoded image in a data:url, HTML-formatted SMTP message, or email attachment, without limitation. It should be understood that image data may accompany text or other characters in the same electronic message communication sent to, received by, and/or delivered from a system electronic address (including non-email electronic message communications like MMS message communications). In some embodiments, only text or characters may be contained within an electronic message communication. In some embodiments, only image data may be contained within an electronic message communication. In some embodiments, image data 6 may comprise one or more camera images. In some embodiments, image data 6 may comprise one or more web-based or URL images, or images which may be selected from a web page of a website. The web-based images may be provided via a third-party server 125, 137, e.g., selected from a database thereon, or may be selected by a user 91, 92 using their mobile device 96, a computing device 95, or kiosk 3, without limitation. According to some embodiments, images may be imported and/or exported or uploaded utilizing one or more system-integrated software applications (e.g., a system “mobile app”). However, according some very simplistic embodiments disclosed herein, a mobile application may not be necessary (e.g., wherein communications to and/or from the system may be made via a website, SMS, MMS, phone call, webpage submission, etc.). According to some embodiments, web-based images may comprise one or more images selected from a third-party profile 130′ which may be an Internet-based profile (e.g., Facebook, Meetup, Instagram, Flicker, LinkedIn). According to some embodiments, web-based images may comprise one or more images selected from a fair use/Creative Commons digital image library. According to some embodiments, web-based images may comprise one or more images selected from Internet search results which may be displayed on a browser. According to some embodiments, web-based images may comprise one or more images selected a search engine or website, including, but not limited to a system website 127 and/or a third-party website, such as a participating entity 65 website.

According to some embodiments, data, user inputs 4, instructions, and/or information may be provided to the system (e.g., in order to manipulate and/or populate a system-integrated database 129, perform a function, and/or complete a transaction) using wireless-enabled technologies (e.g., Wi-Fi/IEEE 802.11, wireless LAN/WAN, cellular data service, wireless sensor/network, short-range wireless communications, infrared communication, Bluetooth/IEEE standard 802.15.1/EDR/LS, Link Management Protocol/LMP, Audio/Video Remote Control Profile/AVRCP, Logical Link Control and Adaption Protocol/L2CAP/ER™/SM streaming mode, Service Directory Protocol/SDP, Radio Frequency Communications/RFCOMM, Bluetooth Network Encapsulation Protocol/BNEP, Audio/Video Control Transport Protocol/AVCTP, Audio/Video Distribution Transport Protocol/AVDTP, Telephony Control Protocol/TCS, Point-to-Point Protocol/PPP, TCP/IP/UDP, Object Exchange Protocol/OBEX, Wireless Application Environment/Wireless Application Protocol—WAE/WAP), Short Message Service (SMS), or Multimedia Messaging Service (MMS), combinations thereof, and/or the like, without limitation).

According to some embodiments, image data 6 may comprise image information relating to one or more participating entities 65 (e.g., vendors). According to some embodiments, image data 6 may comprise image information relating to the system's own brand and/or trade dress (e.g., “send1”, “sharing made simple”, “ShareCard”, or the like, without limitation). Image information relating to one or more participating entities 65 may include, for instance, one or more logos, text-based trademarks, trademark indicia, brand information, trade dress, trademarks, redemption information 64 pertaining to one or more participating entities 65, and/or graphic displayable information which represents one or more particular participating vendor/entities 65, without limitation. Image data comprising image information relating to one or more participating entities 65 images and digital information related thereto may be further appreciated from the figures of the instant application. According to some embodiments, image data 6 may comprise message 25 data; for example data relating to a desired message output 5. According to some embodiments, message data 25 may comprise, for example, one or more text inputs, alpha-numeric inputs, character-based inputs, and/or symbol inputs. These inputs 4 may regard one or more desired messages to be conveyed or otherwise communicated to the system and/or to one or more other users 92 of the system, such as one or more contacts, relatives, co-workers, acquaintances, or friends of a user 91 or users 91 providing the inputs 4. According to some embodiments, message data 25 may be provided to the system and/or from the system via text messaging protocols. According to some embodiments, message data 25 may be electronically sent to or otherwise delivered to users 91, 92 of the system via the system website 127, network 118 (e.g., cellular and/or one or more other types of networks), one or more third-party websites (e.g., a social network/social media website 93 and/or a website of a participating entity 65), and/or a system-based application 147 such as a mobile app downloaded and installed on a user mobile device 96 and/or computing device 95. According to some embodiments, message data 25 may comprise, without limitation, one or more portions of a phrase, a quote, a paragraph, a passage, a greeting, a tiding, combinations thereof, or the like, without limitation. According to some embodiments, message data 25 may comprise certain user data 8, for instance, recipient user 92 and/or purchasing/sending user 91 name 47 information. According to some embodiments, message data 25 may comprise recipient user 92 and/or purchasing/sending user 91 electronic address information, without limitation.

According to some embodiments, image data 6 may comprise system profile 130 image data, such as one or more images instantaneously uploaded (e.g., as a user input 4) or previously uploaded to the system website 127 from a user mobile device 96 and stored in a system-integrated database 129. According to some embodiments, image data 6 may comprise system profile 130 image data, such as one or more images instantaneously uploaded (e.g., as a user input 4) or previously uploaded to the system website 127 from a user computer 95 via the system website 127 and stored in a system-integrated database 129. System profile 130 image data 6 may refer to any data stored on a system-integrated server 122, 136, the system server 128, the system website 128, a system-integrated website, a system database 129, a system-integrated database, a user's system profile 130, a user's third party account 130′, various combinations thereof, and/or the like, etc., without limitation.

According to some embodiments, audio data 7 may be delivered to and/or sent by/from/between system components. According to some embodiments, audio data 7 may comprise security information, such as information regarding one or more passwords, PINs, and/or pass-phrases, without limitation. In some embodiments, the security information may be spoken or otherwise verbally or acoustically communicated to the system through or using a system component such as a system-integrated mobile application, a system hotline, a voicemail communication, and/or via a MMS messaging (e.g., an MMS message containing a “voice note” and/or “visual voicemail” attachment, without limitation). According to some embodiments, security information may be received by and/or interpreted by audio input means provided to a system component (e.g., system-integrated software application 147, a kiosk 3, etc.). In some embodiments, security information may comprise, without limitation, a repetition of a phrase or portion of a phrase delivered to a user's voicemail inbox, a user's email account inbox, a user's phone or mobile device 96 memory or storage device (e.g., incoming MMS text message), and/or to a user's system profile 130 in either visual form or acoustic form, and/or various combinations thereof. According to some embodiments, security information, such as a password/passphrase/pass code may comprise a playback of a file containing a sound recording. According to some embodiments, security information, such as a password/passphrase/pass code may comprise a live recording or real-time transmission (e.g., being received from a first user 91 via one or more system components 3, 95, 96, 128 and being played and/or emitted by a second user 92 via one or more system components 3, 95, 96). In some embodiments security information, such as a password/passphrase/pass code may be uploaded or transferred from data storage means associated with one or more system components 3, 95, 96 (e.g., a data storage disk, solid state storage device, or hard drive associated with the one or more system components 3, 95, 96), without limitation.

According to some embodiments, audio data 7 may include one or more sound-bites, sound clips, audible messages, or digitones which may be of human and/or machine origin, without limitation. According to some embodiments, audio data 7 may include one or more voice recordings made by a user 91, 92 of the system or third party 65, without limitation. In some embodiments, audio data 7 may comprise playback audio from a digital device. According to some embodiments, audio data 7 may be communicated to, between, and/or from system components; for example, to/from one or more system-integrated servers 128, and/or to/from user devices 96 via the internet or other communication network 118 via any communications protocol known in the art (e.g., a network comprising a cellular network, without limitation). According to some embodiments, audio data 7 may be conveyed through one or more various instruments known or commonly used in the art including, but not limited to voicemail, email, social media, as well as MMS protocols and/or combinations thereof, without limitation. According to some embodiments, audio data 7 may be conveyed and/or emitted from one or more system components, such as via a mobile device 96 provided with a system-integrated mobile application 147, a kiosk 3, a computing device 95, a payment terminal, and/or the like, without limitation.

According to some embodiments, user data 8 which may be provided to the system or contained within one or more user profiles 130, 130′, may comprise information about a user and/or users 91, 92 of the system. User data 8 may comprise, for instance and without limitation, one or more of the following pieces of information, without limitation: name information 47 (e.g., pertaining to last name, first name, middle name, middle initial, maiden name, given/family name, nickname, userID, screen name, account name, etc.); account number information 48 (e.g., information relating to a user's system website 127 account number, information 55 relating to a user's credit/debit card account number(s), information relating to a user's banking account number(s), information relating to a user's financial institution 163 account number(s), information relating to a user's member/club account number(s) (e.g., AARP account number, USAA account number, AAA account number, Entertainment Club number, Costco/Sam's/BJ's discount club number, USHPA club account number, ClubCard account number, Rotary Club account number, Club Penguin membership number, Groupon account number, VIP Club membership account number, Diners Club International account number, Realtor membership number, etc.), information relating to a user's insurance company account number(s) (e.g., HIPPA-compliant Blue Cross/Blue Shield account number, Select Health account number, Aetna account number), information relating to a user's payment service company account number(s) (e.g., PayPal account number, Square account number); information 56 relating to a user's shopping account number(s) (e.g., Amazon.com account number, Microsoft Xbox Live Gold Membership card, GNC Gold card membership, eBay account number), information relating to student ID account(s) information, information relating to a user's alumni/fraternal association membership number(s), information relating to one or more customer loyalty account numbers (e.g., Subway Club card, My Starbucks Rewards card), information relating to one or more shopper's cards of a user (e.g., Smiths's card account, Kroger card account, Safeway card account, Fresh Market card account, Whole Foods card account, Pep Boys rewards account, Jiffy Lube Fleet Card account), or other account information 48; user email address(s) or information 49 relating to a user's email address(es) such as an email client-hosting organization or webmail platform (e.g., Google, Yahoo, Facebook, AOL, Microsoft, Corporation); birth date information 50 of a user (e.g., decade, year, month, day, or time of birth, age, and/or age verification information (e.g., over 18? over 21?)); biological or biometric information 51 pertaining to a user (e.g., height information, weight information, hair/eye color information, blood type, information regarding voice or speech patterns, etc.); user passport information 52 (e.g., passport number, issuing country, nationality, issue date); information regarding a user's phone number 53 (e.g., phone number, area code, last four digits, country code, cellular service provider, etc.); address information 54 (e.g., regarding a user's physical address, domicile, mailing address, home address, work address, current address, former address(es), zip code, street number, city, state, town, country, county, province, etc.); user credit/debit card information 55 (e.g., types held, entire credit/debit card number, last four digits of account number, security code, PIN, electronic purse information, security pass code or passphrase, etc.); information 56 regarding a user's frequent shopper or loyalty programs (e.g., frequent flier miles programs and account numbers/balance/values thereof, grocery cards and account balance/values thereof, gas/fuel rewards programs and account balance/values thereof, cash-back awards programs and account balance/values thereof, incentive rewards programs and account balance/values thereof, frequent diner awards account information and account balance/values thereof); information 57 regarding a user's license (e.g., drivers license number(s), issuing state/country, professional license(s) information, certification information); user taxpayer information 58 (e.g., social security number, resident ID number, birth certificate number, tax ID number); user identification information 59 (e.g., information listed on a user's identification card, residency card, alien card, voter registration card, healthcare card, military ID, student ID, information pertaining to a user's online profile ID or alias, demographic information, race/ethnicity information, donor information, etc.); user authorization/authentication information 60 (e.g., security feature(s), crypto algorithm such as triple DES or RSA, password(s), passphrase(s), digital certificate(s), digital signature(s), public key infrastructure (PKI), encryption key(s), fob information, PIN(s), site-key(s), RFID/wireless keycard information, FIPS 201-compliant device information, Smart Card Web Server (SCWS) information, SIM card data, non-repudiation data, data hash information, data encryption/decryption means, trusted third party (TTP) information, etc.); purchaser information 61 (e.g., information of a purchasing or requesting user 91, of a user 91 performing a transaction, of a user originating a request communication to the system, etc.); recipient information 62 (e.g., information of a recipient(s), intended recipient(s), or receiving user(s) or non-user(s) 92, information of a user(s) 92 on a receiving end of a transaction, information of a user(s) 92 receiving a communication from the system, information of a user(s) 92 receiving redemption information 64 via the system, etc.); information regarding a user's preferences 63 (e.g., user's native language, current location, favorites, contacts/relatives/co-workers/friends, user history management preferences—all which may, in some embodiments, be stored in one or more system-integrated databases); and/or other information about a user or users 91, 92 of the system, without limitation. However, in more preferred privacy-respecting embodiments of the invention, system components may ask, prompt, or otherwise require very small amounts of non-personal data or non-sensitive data to be inputted as a user input 4 to a system-integrated database 129. For example, users 91, 92 may provide one or more electronic addresses (e.g., mobile device 91 number, email address, IP address information), physical mailing address information, and/or other publicly available information (e.g., public domain information) as is necessary to implement and/or practice certain inventive features and concepts disclosed herein (e.g., for performing one or more transactions, presenting redemption options, delivering redemption information 64 (e.g., electronically), delivering items, products, goods, or services (e.g., physically), and/or delivery mechanisms afforded by embodiments. It should be understood that a plethora of transactions and/or functions may be performed using various components of the system and methods disclosed herein, and that embodiments may require as much user data 8 as is necessary to perform and/or execute such transactions or functions, without limitation.

According to some embodiments, redemption data 64 (e.g., “redemption information”) may comprise information pertaining to a redemption “option” which may be selected by, purchased by, delivered to, and/or received by a user or users 91, 92, without limitation. However, some practical embodiments of redemption information 64 have been disclosed for understanding of the inventive features and concepts. A redemption option may be provided in many conceivable ways, such as an in an advertisement, or prompt, or other vehicle or instrument for providing an option regarding redemption information 64. For example, one or more redemption options may be provided for the benefit of an individual(s) conducting/originating a transaction or function request, without limitation. For example, one or more redemption options may be provided for the benefit of a group and/or entity who wishes to redeem the redemption option personally (e.g., for themselves), without limitation. For example, one or more redemption options may be provided for the benefit of another individual, group, or entity, without limitation.

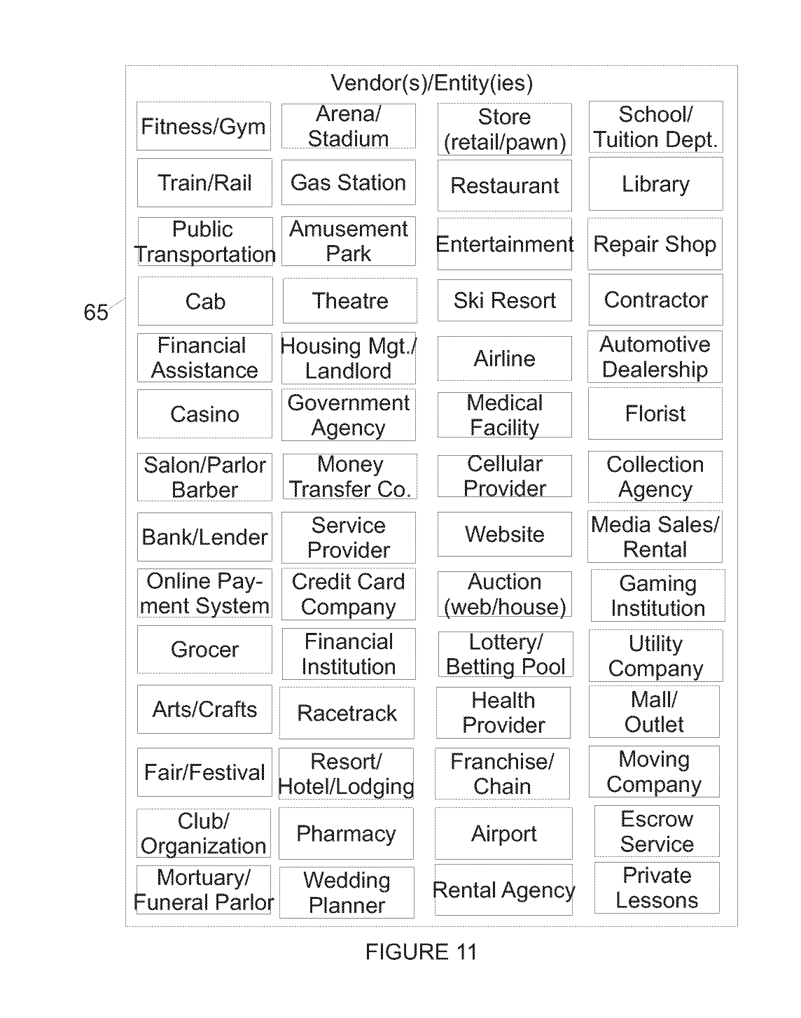

Redemption data 64 may pertain to one or more participating entities 65, such a particular vendor or entity, and preferably, a vendor or entity which participates in the system and methods described herein and which may possess the various support hardware, support software, and/or support communication protocols necessary to: successfully implement various embodiments of the system and methods described herein, successfully implement components of various embodiments of the system and methods described herein, and/or provide a seamless experience for a user or users of the system, without limitation. Where used herein, a participating entity 65 may comprise, without limitation, an individual, a user 91, 92, a vendor, a selling entity, an organization, a corporation or other legal entity, a wholesaler, a manufacturer of items, products, or goods, a service provided or services, a dealer, a merchant, a marketplace (physical or online marketplace), an online website, an electronic commerce institution, etc, without limitation, as may be appreciated from FIG. 11. More specifically, and without limitation, a participating entity 65 may comprise one or more of the following in any variation or permutation of goods and/or services: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, an entity offering private lessons, various combinations thereof, and the like, without limitation.

Where used herein, purchase data 9, according to some embodiments, may comprise information which may be similar in its nature, to information pertaining to redemption data 64. Redemption data 64 may comprise, without limitation, amount information 66, such as a portion of a value or an equivalent value of purchased funds, credits, goods, services, offers, products, or items. In some embodiments, the amount information may comprise a system-defined value, a manufacturer's suggested value, or a retail/market value. According to some embodiments, the amount information may comprise a native value unit (e.g., USD, points, miles, rewards points, number of customer visits, number of customer transactions, number of customer purchases, number of items, products, goods, or services purchased by a user 91, 92, etc.). According to some embodiments, the amount information may comprise a converted or non-converted value form, such as an arbitrary system-based credit unit (e.g., “Go-Bucks”, “send1 credit”, etc.). Various components of the system may, in some embodiments, comprise software comprising algorithms which make such conversions in an expedient manner, for example, in real-time, without limitation. In some embodiments, conversion multiplier values may be provided by various vendors or participating entities 65 and may be stored in a system-integrated database, such as the system database 129 for access and/or user in conversion calculations. It is foreseen that each vendor or participating entity 65 may provide multiple or a plurality of conversion multiplier values, for example, which may be stored in a system-integrated database such as the system database 129—wherein each of the provided conversion multiplier values may pertain to one or more particular items, products, goods, services, or offerings provided by the vendor or participating entity 65. In some instances, amount information may be presented in a unit or format that may be easily identifiable by users and/or participating entities 65, such as in terms of a local monetary value (e.g., credit based on the US dollar, Yen, or Euro, without limitation), as may be apparent from the appended figures and/or readily appreciated by those skilled in the art.

In some embodiments, redemption data 64 may be partially or fully prepaid by one or more users 91. Redemption data 64 may, in some embodiments, be associated with a redemption option (e.g., an option to purchase redemption data 64). In some non-limiting embodiments, redemption options may be associated with one or more items, products, goods, or services, such as a pass (e.g., a toll lane access pass, a VIP access pass, a ski pass, a ride-share pass, a rail pass, a travel card-based pass, an entry access pass, an admission pass, an amusement park pass, an entertainment venue pass, a transit pass, a season ticket pass, etc.). According to some embodiments, redemption data 64 may comprise information 70 regarding one or more valid use dates (e.g., a valid timeframe, a valid hour, a valid day, a valid month, a valid year, a valid time, a valid date range 68, etc.). According to some embodiments, redemption data 64 may comprise information 69 pertaining to one or more dates of issue of a redemption option (e.g., day issued, month issued, year issued, season issued, time issued, etc.). According to some embodiments, redemption data 64 may comprise information regarding one or more expiration dates (e.g., day of expiration, month of expiration, year of expiration, time of expiration, etc.). Partition information 71 may be associated with a redemption option and/or redemption data 64, for example, to accommodate multiple uses, functions, specific uses, or a plurality of different redemption data 64 or redemption options for a single vendor or entity 65 or for a plurality of different redemption data 64 or redemption options for different vendors or entities 65. In some non-limiting embodiments, partition information 71 may comprise store information, such as an issuing store number, one or more valid redeeming store numbers (i.e., of participating entities 65 that are able to fulfill a transaction pertaining to redemption data 64), and/or one or actual redeeming store numbers (i.e., of participating entities 65 that have fulfilled a transaction pertaining to redemption data 64), without limitation. According to some non-limiting embodiments, partition information 71 may form a portion of physical storage in reference to a physical component of the system (e.g., a card 19, 100, 200, 300, 400, a chip or magnetic stripe applied to the card, memory associated with a card 19, 100, 200, 300, 400, and/or image data/indicia provided to a card 19, 100, 200, 300, 400). According to some embodiments, partition information 71 may preferably comprise pointer information to a larger data matrix or array storing a plurality of redemption options and/or redemption information 64, for example, within a system-integrated database 129. Pointer information may include user data 8, such as information pertaining to a sending user 91 and/or recipient user profile 130, 130′. Partition information 71 may, for example, be used to assign, categorize, manipulate, and/or organize information pertaining to a past purchase, multiple past purchases, transactions, unused redemptions, newly added redemption options, newly added redemption data 64, user 91, 92 histories, etc., without limitation. Partition information 71 may, without limitation, be used to assign, categorize, manipulate, and/or organize information pertaining to incoming user funds or credits, etc. Partition information 71 may, in some instances, be used to assign, categorize, manipulate, and/or organize information pertaining to a single user account profile 130, 130′ which may be affiliated with a physical system-integrated card 19, 100, 200, 300, 400, or user data 8 affiliated with a system card, such as a system card account number. According to some embodiments, redemption data 64 may comprise type 72 information associated with one or more types of redemption options pertaining to redemption data 64 discussed herein. Redemption data 64 may comprise information regarding one or more event details, such as details pertaining to a particular venue/location 2 (e.g., arena, stadium, racecourse, concert hall, fairgrounds,), a particular event time, a particular event date, promotions relating to a particular event, performer information, team details, game details, performance information, race information, fairgrounds location information, etc., without limitation. Supplemental data 74, such as registration details, restrictions, vendor options, rules, terms and conditions, terms of use, privacy information, waivers of liability, etc., may be included in redemption information 64, without limitation.

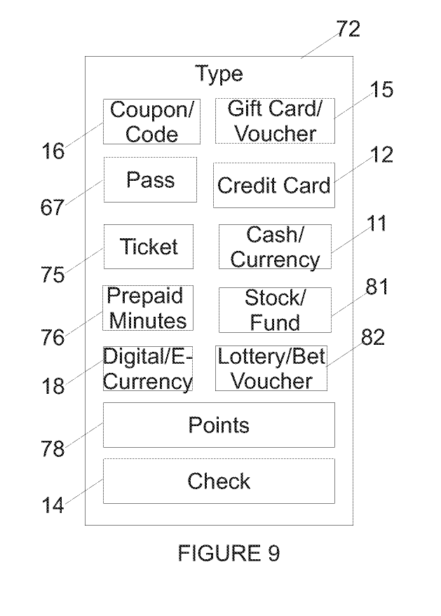

It should be understood that while particular examples are given in this detailed description for illustrative purposes and for understanding practical applications of the inventive features and concepts, redemption data 64 and/or purchase data 9 may include any conceivable tangible type 72 of purchasable funds, credits, item, product, good, or service, including, but not limited to, purchasable offerings, rewards points, loyalty points, frequent shopper points, miles, deals, incentives, coupons, tickets, redemption codes, promotions, funds, cryptocurrencies, tradable assets, holdings, stocks, credits, vendor-accepted tokens/chips, store credit, and the like, without limitation (this may be appreciated from FIG. 9). Types 72 of redeemable options pertaining to redemption data 64 which may be purchased, saved, distributed, transferred, and/or sent using components of the system may, in some instances, comprise tickets 75 or ticket-based redemption information 64. Tickets 75 or ticket-based redemption information 64 may include, for instance, information regarding tickets to movies, tickets to plays, tickets to sporting events, tickets to productions, tickets to concerts, tickets to operas, tickets to a gaming facility or arcade, tickets to a club, ski lift tickets, bowl/skate tickets, admission tickets, integrated tickets, smart card tickets, a ticket to a race, airline tickets, parking tickets, and/or proof of pre-paid parking tickets, without limitation. Types 72 of redeemable options pertaining to redemption data 64 which may be purchased, saved, distributed, transferred, and/or sent using components of the system may, in some instances, include information prepaid minutes 76 or information pertaining to prepaid minutes, such as cell phone minutes, calling card minutes, massage minutes, shop time minutes, service minutes (e.g., legal services, consulting services, computer networking services), labor minutes, and/or the like, without limitation. Types 72 of redeemable options pertaining to redemption data 64 which may be purchased, saved, distributed, transferred, and/or sent using components of the system may comprise information regarding stocks, mutual funds, and/or other tradable asset information 81, without limitation. According to some non-limiting embodiments, stock/tradable asset information 81 may comprise, without limitation, account balances, share prices, number of shares, dividend information, market identifier codes, company names, international securities identifying numbers, ticker/stock symbols, National/International securities identifying numbers, CUSIPs, certificates of deposits, withdrawal certificates, syndicated loan information, tradable asset information, IPO information, wealth management account numbers, exchange traded fund (ETF) information, combinations thereof, and the like, without limitation. Moreover, in some embodiments, lottery or bet-based information 82 such as lottery tickets, wagers, voucher information, scratch offs, betting pool receipts, proofs of bets, wager receipt information, etc. may be purchased and/or redeemed by users of the system using system components. In some non-limiting embodiments, components of the system (e.g., kiosks 3 or payment terminals of participating entities 65) may physically produce and/or deliver lottery or bet-based articles. In some non-limiting embodiments, components of the system may produce and/or deliver electronic versions of lottery or bet-based articles alone, or in combination with respective physical articles thereof. Such electronic versions may include redemption data 64 delivered by any one or more of the protocols described herein, for example, via SMS/MMS/mobile messaging, email, voicemail, web/net (e.g., being accessible by accessing a system-integrated profile 130, 130′ via a system-integrated website 127 and/or via a system-integrated application downloaded to a mobile 96 device and/or computing device 95), or the like, without limitation. Moreover, terms and conditions, such as restrictions, terms of use, waivers of liability, indemnifications, and privacy terms may be associated with certain types of redeemable options pertaining to redemption information 64. In some non-limiting embodiments, in order to accommodate a short amount of characters which may be allotted for SMS/MMS/mobile messaging, delivered email/SMS/MMS/mobile messages may comprise a link, such as an operatively-engageable hyperlink which may direct a user 91, 92 to a site containing more information about particular redemption information 64, such as information pertaining to restrictions, rules, terms, conditions, use, how-to, frequently asked questions (FAQ), and/or the like, without limitation. In some non-limiting embodiments, in order to accommodate a short amount of characters which may be allotted for email/SMS/MMS/mobile messaging, an item number associated with a redemption option (e.g., an option pertaining to purchasable, sendable, and/or receivable redemption data 64) may be looked up using the system website 127 or third-party search engine (e.g., Google, Yahoo, Bing, Startpage, or DuckDuckGo), or an item number associated with a redemption option may be looked up by a user on a website of a participating entity 65 which may be affiliated with the redemption option (e.g., on a vendor/selling entity's website). According to some embodiments, one or more item codes and/or image data 6 affiliated with redemption options and/or redemption information 64 may be provided to physical or online/web-based advertisements, without limitation. Alternatively, in order to accommodate the short amount of characters allotted for email/SMS/MMS/mobile messages, messages sent to, created by, delivered using, and/or received by components of the system (e.g., email/SMS/MMS/mobile messages) according to some embodiments may comprise one or more hyperlinks which may be engaged by users, for example, by pressing a touch screen of a mobile device 96, by selecting one or more hyperlinks via a verbal command, by operatively-engaging a smart phone interface, and/or selected using a phone tracker ball (e.g., those found on BlackBerry mobile devices). It should be understood that in some non-limiting embodiments, redemption information 64 and/or redemption options regarding the same, which may be stored on a system-integrated database 129, may be presented to users in a web-based format, for example, in a user portal environment of the system website 127 which may be accessible via a browser or system application 147 provided to a user's mobile device 96 or computing device 95. The user portal may allow user access to one or more user profiles 130, 130′ wherein information displayed may comprise one or more hyperlinks and/or means for setting preferences 63.

System components 3, 19, 95, 96, 130, including databases, electronic communications, and other components may, where appropriate or possible, comprise image information (e.g., indicia, graphics, designs, pictures, text, photos, overlays, holograms, etchings, embossments, logos, trademarks, printed matter, patterns, lines, characters, etc.), points information (e.g., frequent shopper points, frequent flier miles, member/membership points, customer rewards points, frequent diner credit points, loyalty points, etc.), and/or one or more barcodes (e.g., one or more 1D barcodes, 2D barcodes, universal product (UPC) codes, ISO/IEC 15416-compliant markings, ISO/IEC 15426-2 compliant markings, ISO/IEC 15415-compliant markings, ISO/IEC TR 29158-compliant markings, etc.), without limitation.

In some embodiments, system cards 19, 100, 200, 300, 400 may comprise data storage means, such as a solid state device, a chip (e.g., an integrated circuit, a microprocessor, a security authentication device, a single sign-on SSO device, an EMV chip, an ISO/IEC 7816 device, a contactless “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8/16/32 bit public key dynamic 8 k-1 MB EEPROM with math coprocessor, a 125 kHz proximity read-only device, a 13.56 MHz ISO 14443 0.5-8 kB read/write device, a MiFare protocol device), a proprietary protocol device, an ultrahigh frequency gen 1 or 2 device, a semiconductor, various combinations thereof, or the like, without limitation.

According to some embodiments, system cards 19, 100, 200, 300, 400 may comprise magnetic information storage means 111 (e.g., high-coercivity HiCo means or low-coercivity—LoCo means). According to some embodiments, cards utilized within the system may comprise one or more RFID devices and/or equivalent devices (e.g., an antenna, an electromagnetic field device, a tag, a transponder, a frequency modulating/de-modulating device, a passive reader active tag device, an active reader tag device, a battery assisted tag (BAT) device, electronic product code EPC information, a mobile computing communication device, a smart sticker, a virtual badge device, a wireless tracking device, combinations thereof, and/or the like, without limitation). Alpha-numeric information (e.g., text, characters, numbers, letters, printed indicia, embossed indicia, codes, addresses, cryptotext) may be provided to cards used with the system; for example, in any manner consistent with the disclosure or in any manner which would be an obvious variant of an embodiment discussed herein.

Metadata 90 (e.g., user data 8, participating entity 65 data, use date, use time, use location, place of use information, descriptive information, structural information, copyright/IP information, syntax, hierarchical information, linear/planar schemata, hypermapping data, granularity data, standardization information, cataloging information, technical information, business information, process information, cloud access information, and the like, without limitation) associated with system component use and/or interaction(s) between system components (e.g., card 19 use, mobile application 147 use, use of a mobile device 96 to perform steps disclosed herein, use of a computing device 95 to perform steps disclosed herein, use of a kiosk 3 to perform steps disclosed herein, communications made through the system including between components thereof, etc.) may, in some embodiments, be tracked by one or more participating entity 65 payment systems, and/or stored in a system-integrated database, such as the system database 129. Metadata 90 may, for example, be tracked, exchanged, and/or stored on one or more system-integrated databases 129 of one or more system-integrated servers (e.g., system server 128, participating entity server 136, financial server 122, social media 93 server, external server 125 (e.g., “cloud” or other hosting service server), combinations thereof, etc.). According to some embodiments, various components of the system, such as the system website 127, applications 147 associated with the system, as well as other third-party components 93, 94, 122, 125, 136, without limitation, may be configured to track card 19 use and/or user 91, 92 activity in general, as may be appreciated from the appended drawings. System racking functions and/or activities may, for example, be accomplished utilizing various means for generating location-based data 143 disclosed herein.

According to some non-limiting embodiments, the system and/or various components thereof may comprise integrated social media websites 93, for example, including, but not limited to personal websites, networking websites, business/professional development websites (e.g., LinkedIn), image sharing websites (e.g., Picasa, Instagram, Shutterfly), dating websites (e.g., Match.com, eHarmony), group/club websites (e.g., Yahoo groups, Google circles), meeting place websites (e.g., Meetup), social network services (e.g., Facebook, Twitter, YouTube), and the like, without limitation. In some embodiments, users 91, 92 may choose to link their system profile 130 (e.g., system “account” number and/or one or more system-recognized electronic addresses associated with a system profile 130) with their various social media profiles 130′; for example, to provide improved or seamless transactions between, interactions with/between, and/or communications with/between friends, contacts, co-workers, acquaintances, relatives, and the like, as well as with/between participating entities 65 and users 91, 92, while using the system and/or components thereof. For example, the inventive concepts and features disclosed herein may lead to improved experiences which may be observed while shopping (for oneself or for another), and/or while navigating to find a particular item, product, good, or service (or element thereof, e.g., a seat within a venue/location pertaining to ticket-based redemption information 64) in real-time, and/or in advance. It should be understood that components of the system (e.g., system software 147 or algorithms employed by one or more system-integrated servers 128, and system integrated databases 129) may utilize various information pertaining to a user's third party social media 93 interactions; for example, to provide targeted advertisements, focus a user's attention (e.g., to preferred or reoccurring transactions, functions, products, items, goods, or services), and/or to improve a user's overall experience while using the system, without limitation. In some embodiments, users 91, 92 of the system may add or create one or more new system-based “friends”, in particular, individuals who may partake in a single or frequent transactions with the users 91, 92, without limitation. This may be done, for example, by a user providing amounts of user data 8 associated with said one or more new system-based friends, as an input 4 to the system via a user interface 106. In some preferred embodiments, a user 91, 92 of the system may be able to readily identify one or more products, goods, services, or offers which are “liked” by a potential recipient (e.g., via a system website 127, kiosk 3, or communication to a system-integrated server such as a web-based request submission or electronic message communication (e.g., email/SMS/MMS/mobile message request, such as a “PEEK” request)). Moreover, utilizing system components, a user 91, 92 of the system may, in some embodiments, be able to make better purchasing (e.g., “personal” or “gifting”) decisions, based on the popularity of one or more items, products, goods, services, or offers provided as a redemption option available for purchase. In this regard, a user 91 may select redemption options based on the number of Facebook “likes” by friends, or system-based favorites of other system users (such as contacts or friends). According to some embodiments, selection of redemption options may comprise a system “filter” component, wherein a user may customize the filter component (e.g., using real-time inputs 4 to system components such as data input means 117 or predetermined preset filters which may be user-defined preset filters stored in a system database 129 as user preferences 63). In some embodiments, redemption options having a large number of “likes” or indications of being a “favorite” of one or more other users may serve as recommendations, or “wish-lists”, which may assist a user 91 with purchasing or gifting decisions. In some embodiments, redemption options have a larger number of favorable opinions may be displayed first in a list, or otherwise in a more conspicuous location of a component display or user interface (e.g., at the top of web page, on a first or second page of profile 130, in a broader hierarchy of a website layout, larger in size, bolded, highlighted, in color vs. black and white, etc.).

One or more advertising firms, marketing solutions firms, and/or market research firms 94 may be integrated with the system and components thereof described herein. For example, in some embodiments, integration may be achieved via system software 147, permissions, and access to one or more portions of a system-integrated database 129, based on the permissions. In this regard, data regarding user profiles 130, 130′, such as purchase and redemption histories, may be utilized to help participating entities 65 more efficiently and/or effectively market their products, goods, and/or services to users 91, 92. In some embodiments, one or more reports or reporting structures may be employed, wherein information contained within one or more system databases may be reported to one or more participating entities 65. The one or more reports or reporting structures may be scrubbed to eliminate personal and/or sensitive user data 8; or, the one or more reports or reporting structures may comprise detailed profile 130 information. However, in some preferred embodiments, user data 8 in connection with system profiles 130 which may not be necessary to complete transactions using the inventive functions and concepts disclosed herein, may be held in confidence (e.g., not shared with third-parties in accordance with user agreements). In some preferred embodiments, a user may access one or more of their system-integrated profiles 130, 130′ (i.e., system “account”) using a computer 95, such as a CPU, a desktop computer, a laptop computer, a tablet, or other computing device. In some preferred embodiments, a user may access one or more of their profiles 130, 130′ integrated with the system using a mobile computing device 96, such as a dumb phone, smart phone, a cell phone, flip phone, a tablet, a “connected” car or vehicle device, a smart watch, a portable gaming device, a laptop, a voice over IP (VOIP)-compatible device, a Maxwellian view optical system or other virtual retinal display device, a wearable computer, and/or a wearable computer provided with an optical head-mounted (OHMD) display (e.g., Google Glass device, Oculus device), without limitation.

According to some embodiments, information pertaining to items, products, goods, services, promotions, offerings, funds, credits, points, and/or other conceivable saleable redemption options which may be associated with purchasable redemption information 64 may be accessed by system components; for example, may be accessed via a system website 127 or third-party website, may be accessed via a system application 147, may be accessed via an electronic communication to the system (e.g., via an electronic message from a system-recognized user electronic address to a system electronic address), and/or may be displayed and/or may be accessed via indicia provided to packaging, signs, displays, or advertisements (including TV, radio, mobile-marketing, and/or Internet or web-based advertisements) in manners consistent with this disclosure and/or appreciated from the appended drawings. The information pertaining to redemption options may be updated; for example, by accessing and/or manipulating one or more participating entity 65 databases (e.g., including, but not limited to data storage databases, data center databases, third party databases, third-party support service databases, participating entity supporting databases, external databases 135, third party online gift card exchange service databases, and/or the like), which may be stored on one or more participating entity servers 136 or other external servers 125. In some embodiments, one or more system databases 129 on one or more system servers 128 may be accessed and/or manipulated to update information pertaining to redemption options. Various combinations and permutations of system-integrated database access and/or manipulation steps are envisaged, wherein system software and electronic communications made between system components facilitate the steps of accessing and/or manipulating information contained within one or more system-integrated databases. According to some embodiments, the information pertaining to items, products, goods, services, promotions, offerings, funds, credits, points, and/or other conceivable saleable redemption options which may be associated with purchasable redemption information 64 may be stored in full, or in part, on one or more system databases 129, and updated or otherwise manipulated through interactions with the system website 127 (for example, by accessing a user and/or participating entity online “portal” webpage). Moreover, according to some embodiments, the information may be updated via firms 94 (e.g., Constant Contact) or other service entities (e.g., InComm, Blackhawk Network) used by participating entities to market redemption options and/or redeem redemption data 64. In one preferred simplistic embodiment, at least a system database 129 provided to a system server 128 contains the information, wherein the information may be updated regularly to reflect the most up-to-date information regarding saleable redemption options. For example, according to a participating entity 65 user agreement, a participating entity 65 may provide updated redemption options and/or redemption information 64 at predetermined intervals (e.g., this may be done manually using participating entity inputs 4 such as XML-based file uploads to the system website 127, automatically using system software 147 having participating entity 65 database 136-accessing means (e.g., an API or other software), or other convenient manner).

In some embodiments, one or more financial servers 122 and/or financial databases (e.g., GE Capital Retail Bank (“GECRB”) databases, Discover Financial Services databases, American Express databases, Visa databases, US Bank databases, Co-op network databases, Cirrus databases, Star databases, JPMorgan Chase & Co. databases, Bank of America Corp. databases, The Goldman Sachs Group, Inc. databases, Capital One VentureOne Rewards Credit Card databases, Discover databases, housing credit card rewards points databases, etc., without limitation), which may be affiliated with one or more financial institutions 65, may be integrated with the system and/or components thereof. In some embodiments, financial servers 122 may comprise, for instance, bank servers, credit/debit card company servers, escrow service servers, online or virtual payment system servers (e.g., PayPal servers, Square servers), acquiring bank servers, virtual private servers/farms/or mines (e.g., Bitcoin servers), depositary institution servers, credit union servers, trust company servers, mortgage loan servers, contractual institution servers, pension fund servers, investment institution servers, investment banking servers, underwriter servers, brokerage firm servers, and/or corporate servers, without limitation. In some embodiments, payment data 10, such as funds or credits associated with purchase data 9 or purchases made through the system (e.g., via system kiosks 3, system website 127, or via system applications 147), may be deposited with the system's financial institution (e.g., in an escrow or checking account). For example, in some non-limiting embodiments, upon use of redemption information 64 at a particular participating entity 65 in exchange for one or more items, products, goods, or services, system software 147 may be configured to deliver a request communication to the system's financial institution, wherein the request communication may include a participating entity's user data 8 (e.g., a participating entity 65 electronic address), an amount 66 associated with the used redemption information 64, and an instruction to make the vendor or entity whole; for example, by charging and/or debiting the system's financial account balance with the system's financial institution, deducting an amount of funds or credits associated with a system account which may be consistent with the amount 66 of the used redemption information 64, and/or crediting an account of the participating entity 65 by the amount 66 or portion thereof. According to some embodiments, the participating entity 65 account may be credited in real-time during the transaction, or at a later time, such as a predetermined time intervals. In some preferred embodiments, system software 147 may, upon use of redemption information 64 in exchange for goods/services, credit a participating entity 65's system account (e.g., based on a participating entity 65 electronic address); wherein the system may make a participating entity 65 whole in real-time with system credit, and ultimately, in a non-system credit denomination at predetermined time intervals consistent with a participating entity user agreement. For example, every second, minute, half-hour, hour, day, week, two weeks, or month, system software may determine a difference between a participating entity's starting system credit balance and ending system credit balance, and may determine a credit due (e.g., amount owed to the participating entity 65) or liability (e.g., amount owed to the system or to another participating entity 65); wherein the system's financial institution may electronically credit or debit the respective participating entity's financial institution account, using any means known in the art, accordingly. It is envisaged that the system and/or system's financial institution may, in some embodiments, print a check for a credit due, and may provide it to a participating entity 65 (e.g., a store number, or corporate headquarters) and/or to a participating entity's 65 financial institution via mail. It is envisaged that the system and/or system's financial institution may, in some embodiments, print an invoice and/or create an electronic invoice for a liability, and may provide it to a participating entity 65 (e.g., a store number, or corporate headquarters) and/or to a participating entity's 65 financial institution via mail or electronic mail. Similar functions may be performed entirely electronically (e.g., automatically by software) using direct deposit technologies currently known and/or practiced (e.g., ACH, wire, money order, and/or the like).

In some embodiments, a gift card 19 may be purchased by a first user 91 (e.g., customer, purchaser) from a retailer, from a system website 127, from a third party website (e.g., participating entity 65 website), or a system application 147. Funds or credits associated with the payment data 10 received from the first user 91 in exchange for the purchased gift card 19 may be electronically deposited into an account associated with the system's financial institution. When the first user 91 or end recipient 92 of the gift card uses the gift card 19 at a participating entity 65 (e.g., including, but not limited to physical location/venues 2, one or more websites, one or more web-based marketplaces, and/or one or more application marketplaces like iTunes, Amazon, or Google Play) to redeem a purchased redemption option/redemption data 64, the system may make a payment to the participating entity 65 via the system's financial institution. The payment made to the participating entity 65 may be in full, or in part, depending on certain pre-made contractual arrangements between the participating entity 65 and the system. Such contractual arrangements may be made when the participating entity 65 opens a system account or otherwise signs on with/signs up for the system. Software 147 associated with the system server 128 or a financial institution may alter system database 129 information according to transactions, redemptions made, uses of redemption information 64, added credits, withdrawals made, etc.

One or more external servers 125 (e.g., data storage servers, data center servers, data service center servers, third party database servers, third party corporation servers, third-party application servers, third-party support services, participating entity 65 supporting servers (e.g., having databases containing one or more tables or lists of item/promo descriptions, item/promo numbers, item costs, item/promo UPC codes, item/promo SKU codes, etc.), third party online gift card exchange service servers, cryptocurrency exchange client servers, UPC barcode database-containing servers (e.g., Google Shopping, Yahoo Shopping, Amazon.com, Simple UPC, Zxing.org, UPC Database.org, UPC Database.com, GSI Database, Open Product Data), etc.) may be integrated with the system, in order to facilitate certain outputs 5, tasks, executions, functions, and/or transactions, without limitation. For example, the system may incorporate existing services (e.g., web-based services) for cashing frequent flyer miles, and may comprise related client and/or host software for exchanging information regarding frequent flyer miles between one or more system servers 128 and one or more third party servers (e.g., participating entity 65 servers 136). In this regard, a system application 147 stored on one or more system servers 128 may be able to update, manipulate, and/or utilize system profile 130 information pertaining to frequent flyer miles, in a manner that is consistent with profile 130′ information pertaining to frequent flyer miles stored in third-party databases (e.g., participating entity 65 databases 137). In another example, the system may incorporate and/or communicate with certain online participating gift card/eGift certificate exchanges in a similar manner. In yet another example, the system may connect or otherwise communicate with participating cryptographic exchange clients using software and one or more network 118 communications to facilitate digital currency transactions between users 65, 91, 92 and certain components of the system. Third party application software and/or protocols (which may comprise one or more encryption/decryption keys, etc.), may be integrated with system software as necessary to integrate such services and/or may be integrated with system software as necessary to access one or more respective external servers 122, 125, 136. One or more external databases 135, for example, stored on an external server 125, such as participating entity-affiliated databases 137, gift card information databases, Retail Gift Card Association RGCA databases, databases used for storing rewards points information, and SMS auto-responder databases may be affiliated with external servers 125, without limitation. It should be understood that in some embodiments, databases pertaining to social media sites 93 (e.g., containing profile 130′ information) may, for the purposes of this disclosure, be considered as external databases 135 and/or participating entity databases 137, without limitation.

According to some non-limiting embodiments, when visiting a system-integrated kiosk 3, system website 127, or interacting with a system-based application 147 such as a mobile app configured for use on a mobile device 96 (including vehicles), a user 91 may be prompted to login to their system profile 130, 130′ via a sign-on or login page. For example, according to some non-limiting embodiments, one or more browsers may be used to support the presentation of certain redemption options provided by the system, which may be available for purchase. In some embodiments, once selected, a redemption option associated with redemption information 64 may be added to a cart 133. Items, products, goods, or services within a user's cart 133 (e.g., in the form of one or more selected redemption options) may be purchased via a secure check-out page 132 by the user 91, or, by another user 92 (for example, in an instance where a user 91 adds something to their profile 130 shopping list 144, wish list 144a, or the like, and is accessed by another user 92). Selected redemption options within a user's cart 133 may, in some non-limiting embodiments, be purchased by selecting a “request gift” icon which may be provided within the secure check-out page 132, without limitation. As will be discussed and appreciated from this disclosure, other means (e.g., “peeking” at other users via a text-based request communication to a system electronic address) for obtaining shopping list 144 information (e.g., a wish list 144a or gift list information) of users 91, 92, are envisaged and are within the spirit and scope of this disclosure. According to some embodiments, activation of a “request gift” icon (e.g., via operable engagement, touching, pressing, etc.) by a first user 91 may, via system software 147, prompt another user 92 (e.g., such as a friend, contact, or relative of the first user) to send funds or credits (including forms of redemption information 64, without limitation) to the system via one or more system components; for example, so that an item, product, good, or service may be purchased for or otherwise redeemed by the requesting party 91. In some non-limiting embodiments, the prompt to another user 92 may comprise an alert notice; for example, an alert notice delivered in an electronic message (e.g., mobile application alert, push message, SMS/MMS/mobile message, email, voicemail, web-based notification to a user 92 system-integrated profile 130, social media 93-based post or communication to a user 92 and/or the like) from the system to the another user 92. In some embodiments, as may be appreciated by the appended drawings, an alert notice may comprise an electronic notification on a system-integrated application 147, such as an application configured for use on a mobile device 96.

As another example, a second user 92 may access the system (e.g., in response to a received system notification), via a kiosk 3, via a system application 147 downloaded to their mobile device 96 or computing device 95, and/or by providing one or more unique codes to one or more system electronic addresses (e.g., in an electronic message delivered to a system-provided phone number, long code, short code, email address, social media address, or the like). In some non-limiting embodiments, the one or more unique codes may be provided in an electronic message which may be monitored by the system (e.g., one or more special hashtags contained in an electronic message posted using a social media 93 platform), without limitation. According to some embodiments, the second user 92 may, using a browser (e.g., a kiosk browser, mobile application 147 browser, website 127 browser, or equivalent thereof), peruse a variety of types of redemption options affiliated with purchasable redemption data 64, and/or may be presented with redemption options (e.g., using targeted advertisements, profile 130, 130′ information, user preferences 63, metadata 90, system software algorithms, collaborative filtering (CF) techniques, and/or other recommendation technology based upon user inputs 4 or interactions, without limitation). According to some embodiments, the second user 92 may select one or more redemption options, proceed to a check-out page 132, and may select a “request gift” icon or the like. The second user 92 may be prompted for information (e.g., user data 8) pertaining to who the gift (e.g., selected redemption options) is to be sent from or otherwise purchased by. For example, the information pertaining to who the gift is to be sent from or otherwise purchased by, may include, without limitation, one or more of an intended sender's 91 name, an intended sender's 91 electronic address(s), an email address(es), a phone number(s), a system account number(s), etc. The requested sender (first user 91) may receive one or more messages (e.g., from their mobile device 96) via one or more of the platforms described herein, requesting a payment be made for the particular respective redemption options selected by the second user 92 above. The first user 91 may decide, at his/her discretion, to approve or disapprove (e.g., “decline”) the transaction. For example, the first user 91 may approve or disapprove the transaction requested by the second user 92 by replying to an email/SMS/MMS/mobile messaging application-based message delivered to the first user 91 via system scripts or software 147 provided to a system-integrated server 128, 136, without limitation. For example, the first user 91 may approve or disapprove the transaction requested by the second user 92 by replying to a displayed prompt provided to the first user 91 through a system application 147 installed on the first user's 91 mobile device 96. Other uses of a browser are anticipated. In some embodiments, a browser may “piggy back” off of certain existing architectures and/or infrastructures (e.g., via an add-on); such as, but not limited to, third-party sites or services (e.g., Hotels.com, Priceline.com, Amazon.com, Groupon.com, SkiSite.com); in order to facilitate information 121 transfer to users 91, 92, regarding particular items, products, goods, or services and redemption options regarding the same, without limitation. As may be appreciated from the shown figures, according to some embodiments, a user input 4 interaction may include operatively engaging a displayed “send a thank you” icon or the like, wherein upon engagement with the icon, a new system transaction request may be initiated; wherein recipient electronic address information or other user data 8 may be extracted from a previously received, processed, or delivered communication comprising redemption information 64. As may be appreciated from the shown figures, according to some embodiments, similar “thank you” gifting functions/transactions may be performed in the absence of a mobile application 147, for example, via email, voicemail, SMS/MMS/mobile messaging, voicemail, social media 93 post, and/or web submission protocols, without limitation.

System cards 19, 100, 200, 300, 400 produced for use within the system, by the system, provided via the system, or otherwise used with system components, as well as mobile applications 147 supported on user mobile devices 96 and/or user computing devices 95, may be configured to communicate information to other system components using near field (NFC) communication protocols and/or NFC technologies (including respective hardware/software). For example, system cards may be read by reader means provided to payment terminals. Electromagnetic signals emitted from, and/or image data 6 displayed on, mobile devices 96 may be read by reader means provided to payment terminals. For example, one or more digital wallets stored on a user's mobile device 96 may be used, withdrawn from, and/or credited based on user input 4 selections made during system interactions with system components (e.g., kiosks 3 and payment terminals). Moreover, system cards 19, 100, 200, 300, 400 and/or mobile devices 96 associated with system cards (which may be smart phones configured to support a system application 147) may interact with NFC-compatible payment receiving means 100 provided to venue/locations 2 of various participating entities 65. Such “tap-and-go” functionalities may improve customer experiences when using the system and/or interacting with system components. However, some embodiments, in their most basic or simplistic forms, may only include basic elements; for example, wherein all that may be necessary for a user 91, 92 to enjoy the benefits and advantages of the inventive concepts and features of the system, methods, and/or apparatus thereof disclosed herein, is one or more “dumb” phones or landline phones (e.g., such as a pre-paid phone which may be a flip phone or phone with no sophisticated means for accessing the Internet). In some basic embodiments, all that may be necessary for a user 91, 92 to enjoy the benefits and advantages of the inventive concepts and features of the system, methods, and/or apparatus thereof disclosed herein, is access to an email account (e.g. webmail). In some basic embodiments, all that may be necessary for a user 91, 92 to enjoy the benefits and advantages of the inventive concepts and features of the system, methods, and/or apparatus thereof disclosed herein, is access to social media 93, via a social media profile 130′ or account 48 (e.g. a Facebook or Twitter account). In some basic embodiments, all that may be necessary for a user 91, 92 to enjoy the benefits and advantages of the inventive concepts and features of the system, methods, and/or apparatus thereof disclosed herein, is access to a system website 127 in combination with one or more electronic addresses.

Throughout various interactions between a user 65, 91, 92 and one or more system components, and/or between users 65, 91, 92 using system components, a number of updates 142 may be made within the system and/or external systems. Updates may comprise, for instance, and without limitation, account updates (e.g., system account updates, third party account updates, user financial account updates, user loyalty account updates, user frequent shopper account updates, user frequent flyer miles account updates, user hotel stay points accounts updates, user shopper rewards accounts updates, user frequent diner points account updates, etc.), system updates, system-integrated database updates, system database 129 updates, system-integrated website updates, system website 127 updates, system-integrated server updates, system server 128 updates, payment data 10 updates, purchase data 9 updates, redemption data 64 updates, user data 8 updates, audio data 7 updates, image data 6 updates, etc., without limitation). Such updates may occur during user interactions with a participating entity 65, for instance, in real-time upon checkout, payment, or redemptions (e.g., use of redemption data 64 associated with gifted and/or pre-purchased redemption options) made using system components, including interactions at brick-and-mortar establishments and online establishments (e.g., a participating entity 65 website). Updates may happen automatically, or upon distinct user inputs 4. For example, updates may occur automatically when a user 91 may be shopping in a (physical) particular venue or location 2, when a user 91 may be shopping in a (virtual) particular online venue or location 2, and/or when a user may be located in a particular location within a structure of a venue/location 2 or participating entity 65. Location-based and/or time-based technologies may be employed to trigger updates (e.g., changes to user profile 130 information, changes to system-integrated database information, etc.) based on physical and/or online, presence, based on one or more physical and/or online movements, based on physical and/or online habit(s), based on physical and/or online motion(s) (e.g., “click paths”), based on one or more physical and/or online patterns, based on one or more communications made using system components, based on combinations thereof, and/or the like, without limitation.

Some embodiments may utilize a credit-based system, e.g., where both cryptocurrency and other forms of traditional currency may be used to purchase system-recognized and/or system-based credits (e.g., “system credit(s)”); wherein system credit may be divided, allocated, and/or subsequently spent at participating entities 65 in any conceivable practical fashion. According to some non-limiting specific embodiments, system credits may comprise a fanciful name (e.g., “Go-Bucks”, “send1” credit, “ShareCard” credit, or other conceivable fanciful name for the system-based credits).

According to some embodiments, when system credits are presented to a participating entity 65 (e.g., by selecting an option presented by an online check-out page or presented to a checkout terminal such as a cash register at the point-of-sale) by a user, software provided to or otherwise integrated with the participating entity's payment receiving means 100 may send an electronic communication to a system-integrated server 128, the electronic communication comprising information pertaining to a requested amount due. According to some embodiments, the electronic communication may comprise image data 6, audio data 7, user data 8, purchase data 9, redemption data 64, payment data 10, combinations thereof, and/or the like, without limitation. The system, upon receipt of the electronic communication, may access a system-integrated database 128, for example, to obtain profile 130 information affiliated with the user performing the transaction, for example, to verify the user's account information, determine an account status, and/or determine a current account balance of the user (e.g., system account balance comprising system credit). If there are sufficient system-recognized credits in the user's system account, then the system software may debit the user's system account balance, and may credit the participating entity's system account balance with system credit in an amount equal to, or slightly less than the amount debited from the user's system account balance. Else, if there are sufficient system-recognized credits in the user's system account, then the system software may debit the user's system account balance, and make a direct deposit payment (e.g., via a system financial institution server 122 or third party financial institution software), to the respective participating entity 65 (e.g., into a financial institution account of the respective participating entity 65). In some embodiments, a direct deposit payment amount may be an amount which is an equivalent amount or slightly less than an equivalent amount of the system credit presented by the user 91 to payment receiving means 100 of the participating entity 65. In some embodiments, a direct deposit payment amount may be an amount which is an equivalent amount or slightly less than an equivalent amount of one or more items, products, goods, or services associated with redemption information 64 presented by a user 91, 92, to payment receiving means 100 of the participating entity 65. According to some embodiments, system credit applied to a participating entity's system account balance by system software 147, and/or system credit contained within a participating entity's system account balance (e.g., on a system database 129, within in the participating entity's profile 130) may be converted to a different payment data 10 type of funds or credits using system components; for example, periodically, based upon a participating entity user agreement with the system. In other words, in some embodiments, periodically, the system's financial institution may direct deposit a financial institution account of the respective participating entity 65, and may debit a system account affiliated with the system's financial institution (e.g., a system account on a database 138 stored on the system's financial institution server 122), wherein the debited amount may or may not equal the direct deposit amount according to the participating entity user agreement.

According to some embodiments, redemption information 64 contained within a profile 130 of a participating entity 65 may be exchanged for system credit, for example, upon a request electronic communication from the participating entity 65 to the system. In some embodiments, the electronic communication may comprise a web-based communication, for example, a communication made through the system website 147 (e.g., via an accessed website 127 portal, or via a web-based submission made on a webpage of the system website 127). In some embodiments, the electronic communication may comprise an electronic message sent to an electronic address of the system, wherein the electronic message may be comprised of a protocol discussed herein (e.g., email, voicemail, SMS, MMS, mobile messaging, social media post, etc.). According to some embodiments, redemption information 64 contained within a profile 130 of a participating entity 65 may be exchanged for system credit at any time, or at predetermined times. According to some embodiments, redemption information 64 contained within a profile 130 of a participating entity 65 may be exchanged for funds or credits (e.g., payment data 10 of a different type) at any time, or at predetermined times. According to some embodiments, system credit contained within a profile 130 of a participating entity 65 may be exchanged for funds or credits (e.g., payment data 10 of a different type) at any time, or at predetermined times. According to some embodiments, an equivalent of system credit presented by the user 91 to the payment receiving means 100 of the participating entity 65, for example, electronic funds, may be stored at the system's financial institution. In some embodiments, after presentation of the system credits to the participating entity's payment receiving means 100, the user's profile 130 information (e.g., account information) may be updated so as to reflect a loss of system-recognized credits. Users 91, 93 of the system described herein may utilize funds or credits (including redemption data 64) purchased and/or received through the system, via system components 3, 95, 96, 127, with their mobile device 96, 96a, 96b. In some embodiments, the mobile device 96, 96a, 96b, may, comprise a smart mobile 96 or portable computing device 95, such as a wearable device, which is operatively linked to the system network 118. The smart mobile 96 or portable computing device 95 may comprise a system application 147. In some embodiments, a mobile device 96, 96a, 96b may comprise a dumb mobile device which links to the system network 118 via cellular network communication protocols, such as text-based messaging protocols (e.g., email/SMS/MMS communication protocols, cellular phone call protocols, and the like). In some embodiments, funds or credits may be transferred to a user's digital wallet stored on a mobile device 96. In some anticipated embodiments, once funds or credits have been transferred to a mobile device 96 of a first user, the first user may utilize the value associated with the transferred funds or credits with various types of mobile payment solutions and/or protocols (e.g., Google wallet, Apple Pay, ISIS (now Softcard), Merchant Customer Exchange “MCX” (e.g., CurrentC), Square wallet, PayPal, etc., without limitation). According to some embodiments, mobile payment solutions may include, for instance, the purchasing of goods and/or services at a participating entity 65 by scanning, tapping, and/or placing the mobile device 96 near a terminal having the relevant NFC technology, for example, using suitable mobile commerce software known to those of ordinary skill in the art. According to some embodiments, other known forms of mobile payment solutions may be implemented with the system to take advantage of the inventive concepts and features, without limitation. Such mobile commerce software and solutions may, in some embodiments, include system and/or third-party software that enables use of mobile device 96-based digital wallets with participating entity payment receiving means 100, as well as system payment receiving means 100 provided to system components 3, 127, 147. A user 91, 92 (e.g., a consumer) may, in some embodiments, utilize funds or credits (including including payment data 10 and redemption information 64) by providing redemption data 64 sent to a mobile device 96 and/or computing device 95 to a point-of-sale clerk, to an operator (e.g., human or machine-automated operator) of a toll free number (e.g., a system electronic address), and/or to one or more website 127-provided fields, without limitation. A user 91, 92 (e.g., a consumer) may utilize funds or credits (including payment data 10 and redemption information 64) by providing redemption data 64 sent to the mobile device 96 and/or computing device 95 to a barcode scanner or other reading device situated adjacent or otherwise integrated with a payment terminal or other payment receiving means 100 described herein, without limitation. According to some embodiments, mobile devices 96, computing devices 95, kiosks 3, and/or other system components described herein may comprise, without limitation, a wireless connection and/or a wireless device such as a transceiver, which may be suitable for Wi-Fi connections or wireless near field (NFC-based) communications (e.g., Bluetooth), without limitation. In some instances, the system network 118 may comprise cellular and/or GPS-based networks, without limitation. Information communicated across the system network 118 may be exchanged with one or more remote computers, gateways, mobile devices 96, system-integrated websites 93, 127, one or more system-integrated servers 122, 125, 128, 136, and/or computers or controllers associated with the one or more system-integrated servers, third-party websites 93, third party groups 94 such as marketing solutions firms 94, financial institutions 163, online marketplaces, online auctions, online mapping functions, online search engines, third party exchanges, clients, hosts, and/or combinations thereof, etc., without limitation, via a suitable communication link, using network connection means.

According to some embodiments, system-integrated servers 122, 125, 128, 136, may comprise a suitable processor and memory associated with a controller, for example, in the form of a central processing unit (CPU) that may serve to control, via software comprise algorithmic logical expressions, one or more system-integrated database 129, 137, 138-manipulating functions, such as receiving customer inputs 4 directly or indirectly via one or more system components (e.g., from a remote kiosk 3, computer 95, and/or mobile device 96 supporting client software). According to some embodiments, the CPU in combination with specialized system software 147 configured with third party API's and database access means (e.g., code comprising MySQL syntax) may facilitate the sending and receiving of information such as image data 6, audio data 7, user data 8, purchase data 9, redemption data 64, and payment data 10, without limitation. The CPU in combination with specialized system software 147 configured with third party API's and database access means (e.g., code comprising MySQL syntax) may facilitate one or more outputs 5, such as: electronically creating, accessing, sending, receiving, displaying, encoding, decoding, encrypting, decrypting, processing, forwarding, using, converting, and/or transferring image data 6; electronically creating, accessing, sending, receiving, displaying, processing, forwarding, using, converting, and/or transferring a receipt 20 and/or receipt information; electronically creating, accessing, sending, receiving, displaying, encoding, decoding, encrypting, decrypting, processing, parsing, requesting input in, forwarding, using, converting, and/or transferring an email; electronically creating, accessing, sending, receiving, displaying, encoding, decoding, encrypting, decrypting, processing, parsing, forwarding, using, converting, and/or transferring a confirmation number; electronically creating, accessing, sending, receiving, displaying, encoding, decoding, encrypting, decrypting, processing, requesting, transmitting, forwarding, using, converting, and/or transferring audible information, for example, audio data 7 in an audible or converted visual format; electronically creating, accessing, sending, receiving, displaying, encoding, decoding, encrypting, decrypting, processing, parsing, requesting, requesting input from, forwarding, using, converting, and/or transferring a text message (e.g., an SMS/MMS/mobile messaging-based communication); electronically creating, accessing, sending, receiving, displaying, encoding, decoding, encrypting, decrypting, processing, requesting, transmitting, requesting input from, forwarding, using, converting, and/or transferring a voicemail; electronically creating, accessing, sending, receiving, displaying, encoding, decoding, encrypting, decrypting, processing, requesting, transmitting, requesting input from, forwarding, using, converting, and/or transferring a message (e.g., one or more physical and/or electronic messages); electronically adding, depositing, withdrawing, creating, accessing, sending, receiving, displaying, requesting, transmitting, forwarding, using, converting, and/or transferring postage or otherwise adding, depositing, withdrawing, creating, accessing, sending, receiving, displaying, requesting, transmitting, forwarding, using, converting, and/or transferring postage-based credits; electronically depositing, withdrawing, sending, receiving, converting, calculating, adding, subtracting, forwarding, using, converting, and/or transferring currency (including physical and/or digital forms of currency); providing one or more updates to one or more system components (e.g., one or more system-integrated databases 129, 137, 138); electronically sending, receiving, adding (e.g., to a system database), aggregating, processing, compiling, requesting, monitoring, tracking, storing, displaying, printing, communicating, forwarding, using, converting, and/or transferring location data associated with various system components; electronically creating, accessing, sending, receiving, displaying, encoding, decoding, encrypting, decrypting, processing, requesting, transmitting, updating, forwarding, using, converting, and/or transferring purchase data; and/or electronically creating, accessing, sending, receiving, displaying, encoding, decoding, encrypting, decrypting, processing, requesting, transmitting, updating, forwarding, using, converting, and/or transferring redemption-based data, without limitation. It can be appreciated from this disclosure and from the appended drawings that according to certain embodiments, other system components 93, 94, 96, 122, 125, 127, 136 may include features, elements, and/or functions which may be similar to those described above.

The CPU may be, and/or may comprise any logic processing unit known in the art, including, but not limited to, digital signal processors (DSPs) and application-specific integrated circuits (ASIC). According to some embodiments, the CPU may comprise a single CPU or multiple CPUs. Memory associated with CPU 97 may include read-only memory (ROM) and/or random access memory (RAM), without limitation.

Components of the system may facilitate delivery of various types 72 of physical and/or electronic redemption options, for example, redeemable vouchers, receipts, eGift certificates, prepaid minutes (e.g., long-distance calling minutes, cellular provider credit cards, cards redeemable for services), passes, electronic cash values, currency, credit card credits, debit card credits, codes, coupons, tickets, promotions, offers, lottery tickets, scratch-off tickets, pawn slips, loan/promissory notes, rain-checks, customer loyalty cards, etc. For example, in some embodiments, components, such as a system kiosk 3 may provide physical and/or electronic redemption options, without limitation. In some embodiments, components, such as a mobile device 96 or computing device 95 (e.g., payment terminal) may be configured to provide at least electronic redemption options, and may be further configured to provide physical redemption options, for example, if operatively connected to printing means 104, without limitation.

According to certain embodiments, system components such as a system website 127 and/or system application 147 may include software and/or network-supported communication means for creating, accessing, sending, receiving, displaying, encoding, decoding, encrypting, decrypting, processing, requesting, transmitting, requesting input from, forwarding, using, converting, and/or transferring information regarding various types 72 of electronic redemption options, for example, redeemable electronic vouchers, electronic receipts, electronic eGift certificates, mobile/digital wallet-compatible funds or credits, electronic gift cards (e.g., including machine-readable electronic gift cards), electronically redeemable prepaid minutes (e.g., calling minutes, cellular provider credits, credits for services), electronic passes, electronic money/funds, digital currency (e.g., Bitcoin), credit card credits, debit card credits, electronic codes, digital coupons, electronic tickets, promotions, offers, digital lottery tickets, electronic scratch-off tickets, electronic pawn slips, electronic loan/promissory notes, electronic rain-checks, various combinations thereof, and the like, etc., without limitation. In some embodiments, system components may include other, less, or additional features, elements, and/or functions. In some embodiments, features, elements, and/or functions may differ from those described above, without limitation.

In still further embodiments, the system may include more or fewer features than which is described above. In some embodiments, system components such as system kiosks 3, as well as system applications 147, mobile devices 96 utilizing the system, and/or properly networked computing devices 95 (e.g., having access to the system website 127 or system-integrated server 128), without limitation, may exchange information with one another and/or with one or more remote computers (e.g., one or more computers or controllers networked with the system server 128, one or more participating entity 65 payment terminals, one or more vendor websites, one or more active inventory management systems 153, and/or one or more location-based positioning systems 159, and/or the like, for example, via a web interface (e.g., system website 127) by way of one or more communication links through the system network 118 (which may comprise the Internet, cellular network, or other data communication network or protocol, without limitation). For example, in some embodiments, communications between system components may comprise one or more data communications over a public network, such as Internet communications and/or cellular tower-based communications. In some embodiments, communications between system components may comprise one or more data communications over a private network, such as peer-to-peer/point-to-point (P2P) communications, Intranet-based communications, wireless (e.g., Microwave Private Point-to-Point Internet) protocol, and/or other private distributed application architecture, without limitation. In some embodiments the system server 128 may comprise and/or be operably connected to one or more host computers which may facilitate exchanges of information between remote “client” system components, for example, system components which may comprise system-integrated software 147 and/or system-integrated third-party software, without limitation. According to some embodiments, remote “client” system components may comprise system kiosks 3, remote computing devices 95, mobile devices 96, servers 122, 125, 128, 136, third party platforms (e.g., marketing solutions 94 systems and/or social media platforms), websites 93, 127, payment receiving means such as payment terminals/systems (including system-supported and non-system supported payment terminals/systems), active inventory management systems 153, security systems, positioning systems 159, and the like. According to some embodiments, private network communications may be utilized on the back end or middle of transactions (server-side communications), without limitation. According to some embodiments, private network communications may also be utilized on the front end of transactions (e.g., sending and/or receiving side of transactions), without limitation. According to some embodiments, front end communications (e.g., sending and/or receiving side of transactions, for example, users 65, 91, 92 sending and/or receiving electronic communications to a system-integrated server using system components) may utilize public Internet-based (e.g., Wi-Fi) and/or cellular tower-based communications, without limitation.

The system browser pages of the system website 127, mobile enabled system website (i.e., “mobile site”), mobile application, or payment terminal displays, may provide an interactive vehicle for a user 91, 92 to present input data to a component of the system, or manipulate database 129 information. The system component may receive one or more pieces of input data from a user 91, such as a form or page with fields to be filled in, icons to be touched, menus to be selected from, pull-down menus to be selected from, or one or more entries to be entered, thereby allowing one or more many redemption options to be selected. Browser buttons, hypertext links, sliders, back and forward buttons, return to home buttons or other known user interface tools for receiving user input may be used. While certain foreseeable ways of displaying information to system users are shown and described, it will be readily appreciated by those being skilled in the relevant art that various other alternatives may be employed.

Browser pages, screen displays, and image information provided to users (including that of the system, third parties, and/or participating vendors/entities) while utilizing the system website 127 or mobile application may be stored as display descriptions, graphical user interfaces, or other methods of depicting information on a computer screen (e.g., commands, links, fonts, colors, layout, sizes and relative positions, and the like). For example, browser page layouts and information or content to be displayed on a given browser page of a given system component may be stored in the system database 129 communicating with the system server 128.

Where used herein, a “link” may refer to a resource locator identifying a resource on the system network, such as a display description provided by an organization having a site or node on the system network. A “display description,” may refer, generally, to any method of automatically displaying information on a display in any of the above-noted formats, as well as other formats, such as email or character/code-based formats, algorithm-based formats (e.g., vector generated formats), or matrix or bit-mapped formats. While certain examples of embodiments are described herein using a networked system involving multiple system components communicating with each other via the internet, cellular network, cellular service provider, SMS messaging center, or other network 150, it should be understood that some or all of the system features and/or advantages described herein may be implemented using a single-computer, a single mobile device 96, a single terminal, or a single system kiosk.

Non-limiting examples of redemption options may comprise obtaining or sending physical or electronic gift cards relating to a particular vendor or entity (e.g., a Starbucks®, Subway®, Barnes & Noble®, iTunes®, Target®, Wal-Mart®, IKEA®, or Home Depot® gift card), obtaining or sending physical or electronic gift cards relating to a particular product, service, good, brand, line, or portfolio (e.g., a Hershey's®, Levis®, Martha Stewart's Living®, Nine West®, Samsung®, Gillette®, Nike®, Pepsi®, Gucci®, Frito Lay®, Kraft®, Volkswagen®, Shell®, Chanel®, Heineken®, Sony®, Heinz®, Tabasco®, Nabisco®, Nestle®, General Mills®, Netflix®, TracFone®, Redbox®, or General Electric® gift card), making an electronic donation to a charity personally or in another individual's name (e.g., St. Jude's Children's Hospital/ALSAC, Ronald McDonald House, ASPCA, United Way), adding additional miles to an existing (e.g., Delta SkyMiles®, United MileagePlus® miles, American Airlines AAdvantage® travel awards) user account—such as a personal account or other individual's account, purchasing or sending a personal coupon or a coupon for another individual or group (e.g., free bowling and shoe rental for additional lane players with the full price purchase of two adults for the same lane, Free Appetizer with Applebee's entree), purchasing or sending a personal pre-paid voucher (e.g., “Enjoy 3 free introductory guitar lessons from AJ”, or “Free introductory flight in a Cessna 172 through Philips Aviation school”, “Learn to swing dance in 8 classes with Emma Lee”, “Pottery 4 Dummies class”, “Free 2 hour photography workshop with Ryan”, or “FREE up to 5 quart synthetic oil change from Jiffy-Lube®”), receiving a physical or electronic check (e.g., including an image or icon, rain check, certified check, cashier's check), a physical or electronic receipt for a purchased stock, mutual fund, or tradable asset, receiving or sending a personal credit card or credit card credit, receiving or sending a gift credit card or credit card credit in a recipient's name, receiving or sending a personal debit card or debit card credit, receiving or sending a debit card or debit card credit to a recipient, receiving a lottery ticket or sending a lottery ticket or credit to purchase a lottery ticket to another individual (e.g., Virginia Lottery, MegaMillions, Powerball), purchasing or sending a ticket (e.g., a machine-readable UTA transit pass, a public transportation ticket, a sporting event ticket, a play ticket, a theatre ticket, a movie ticket, a concert ticket), paying for another individual's speeding ticket, purchasing or sending a pass (e.g., a EuroRail Eurail pass, a club VIP pass, a machine-readable UTA transit pass, a direct-to ski lift ALTA pass, a WMATA DC Metro area pass), purchasing an eGift certificates (e.g., Amazon.com®), adding or sending points to an existing points account (Sonic Cruisers Club points, Subway® points)—such as a personal account or other individual's account, purchasing and/or sending an eCertificate (from, for example, Amazon.com®), sending and/or depositing money (e.g., coins, paper currency, credit, etc.) into an account, withdrawing money from a personal or other individual's account (e.g., from a PayPal® or other online account), and/or purchasing an item, product, good, or service online from a checkout page, without limitation.

Any one or more of the aforementioned redemption options may be personalized or customized in some way with image data, text (e.g., in the form of personalized messages). According to some embodiments, the redemption options may be provided with an option to make redemption information “non-transferable” or “non-exchangeable”; for example, to assure a donor of a gift that only the recipient may utilize a redemption option for its intended purpose. The redemption options may be provided and/or delivered in a physical or electronic format, and may be utilized for instant use by the purchaser or sent by the purchaser to another individual, for instance, to the other individual's system profile 130, 130′.

With regard to the system website 127, users may be presented with a number of different types of redemption options, such as goods, services, promotions, or offerings when using the system. Redemption options may be sorted and/or categorized in order to prevent/limit user confusion and improve customer experiences with the system. For example, a user of the system may wish to select from a list of presented redemption options based on alphabetical order of vendors/entities. A user may sort redemptions based on the particular type of redemption option. A user may add or remove certain redemption options from their system favorites or wish lists. A user may configure their preferences such that only their favorite redemption options are displayed, and/or such that only their favorite redemption options are displayed.

User-selected redemption options and types of purchase data or redemption data which may have been purchased or given to a user may be stored on one or more networked servers (e.g., the system server 128) and then re-accessed by the user via a mobile device 96, 96a, 96a, the system website, or a system application (e.g., mobile app) the next time the user accesses their profile 130, 130′. Redemption options may be stored, received, sorted, and/or filtered in various ways.

A user of the system may log into a system website 127 using the internet or other network 150. The system website 127 may be associated with one or more online marketplaces within a network of electronic commerce websites which communicate with each other on a shared system-integrated network. The user may access the system website 127 via a remote computer (e.g., a tablet, a personal computer, a web-based digital television system or service, a gaming device (e.g., Nintendo Wii, Microsoft X-box, Sony PlayStation, etc.)) or a personal handheld or portable device such a tablet, mobile phone, PDA, laptop, portable gaming console, or any other small device with access to the system website 127) to access their user profile(s) 130, 130′. While in a user profile 130, 130′, a user 91 may, set, change, and/or view one or more user profile 130, 130′ parameters such as a user's preferences, favorites, closest contacts, relatives, or friends, shopping lists, payment data, redemption data, purchase data, user data, audio data, image data, transactional or interactional history(ies) with the system, etc.

A user 91 of the system may enter information regarding or link a third-party account, such as a social network 93, to share information between the third-party account and the system account by setting up user password and login information relating to the third-party account in their system preferences. This setup may be done via the user's mobile device 96 (e.g., by calling or texting their unique profile ID number to a system number or otherwise providing their third-party account online profile number to the system) system website 127, system application 147, or a system kiosk 3. A user may have access to and may interact with information provided by the third-party account, such as “likes” or favorites information of the user 91 or of the user's contacts, relatives, or friend(s) of the system and/or friends of a third party application. As discussed herein, a user may utilize system-based credits to purchase various redemption options provided by the system which are searchable and purchasable via the system website 127, a third-party search engine, or a vendor/selling entity website.

Various embodiments may provide personalized automated shopping experiences through integration with social networks 93 and/or personal phone contact lists, allowing users 91, 92 to share their individual experiences of items with friends, facilitated by providing a unique item code number to items. Integration of social media websites 93 may enable users 91, 92 of the system to integrate specific information about their own favorite goods, services, promotions, and/or offers with the system. Moreover, integration of social media websites 93 may enable users 91, 92 of the system to integrate specific information about goods, services, promotions, and/or offers that are “liked” by friends with various components of the system.

Social network 93 friends' previous transactions and interactions may be displayed by components of the system. Moreover, users' experiences while using system components such as purchasing or receiving goods or services may be automatically customized with information obtained from a social network 93. According to some embodiments (an depending on set user preferences), a user may be able to publish information on a social media site 93 automatically, for example, by texting an item code, to a system-provided 10-digit number or short code.

It should be understood that process/method step descriptions, illustrations, or blocks shown in the figures are figurative in nature and that these process/method step descriptions or blocks represented in the figures represent modules, segments, or portions of code which include one or more executable instructions for implementing specific logical functions or steps in the process, and alternate implementations are included within the scope of broader embodiments, in which functions may be executed out of order from that shown or discussed, including substantially concurrently or in reverse order, depending on the functionality involved, as would be understood by those having ordinary skill in the art.

Although the exemplary non-limiting routines described herein may have been discussed in particular orders, or in a specific format, the various steps may be implemented in other orders or formats and various steps can be added and/or omitted from the routines without departing from the present technology. Accordingly, the routines described herein are not limited to the particular representative embodiments described above.

Turning now to FIG. 10, a card 100 may be provided at any brick-and-mortar or online retailer, for example, provided to an existing conventional gift card display rack. The card may comprise system card “how to use” instructions 100 (e.g., how to activate, how to visit a system website 127, how to link a profile 130, 130′, etc.), indicia 102 relating to sending funds (e.g., a special code, address, or instructions pertaining to how to transfer funds or credits associated with the card 100), indicia 103 relating to how to request funds from another individual, preferably a user of the system having a system card (e.g., a special code, address, or instructions pertaining to how to request funds or credits associated with the card 100), indicia 104 relating to sending an item or items (e.g., a special code, address, or instructions pertaining to how to buy and send or otherwise transfer an item using funds or credits associated with the card 100), indicia 105 relating to buying an item or items (e.g., a special code, address, or instructions pertaining to how to buy and receive or otherwise utilize funds or credits associated with the card 100 to purchase electronic or physical goods or services, whether online or at a brick-and-mortar venue), indicia 106 relating to liking an item or items (e.g., a special code, address, or instructions pertaining to how to like and/or share or otherwise perform a posting operation consistent with an online profile, such as an online group, web-based social network, etc., without necessarily utilizing funds or credits associated with the card 100, and/or without necessarily needing to add funds or credits to the card 100), indicia 107 relating to adding an item or items to a wish list (e.g., a special code, address, or instructions pertaining to how to add or otherwise make note of an item without necessarily using funds or credits associated with the card 100); wherein the wish list may be or may comprise a third-party account wish list (e.g., a Facebook wish list, an Amazon.com wish list, a Walmart.com wish list, an eBay wish list, an Overstock.com wish list, etc.), a system-based wish list, or the like, indicia 108 relating to recommending an item or items to a contact, relative, or friend (e.g., a special code, address, or instructions pertaining to how to send or otherwise make note of an item on another's mobile device, email account, social network profile 130′ (e.g., “wall”), system profile 130 etc., without necessarily using funds or credits associated with the card 100); and indicia 109 pertaining on how to activate the card, particularly how to link the card with a user's mobile device by texting or calling an activation number provided on the card or card holder. Cards 100 according to some embodiments may comprise one or more system card barcodes 110 (e.g., 1D bar code, 2D bar code, QR code, universal product code/UPC, ISO/IEC 15416-compliant markings, ISO/IEC 15426-2 compliant markings, SO/IEC 15415-compliant markings, ISO/IEC TR 29158-compliant markings). The barcodes 110 may be provided on the back of the card 100, and/or the front of the card. Each barcode 110 may provide different functions, such as for identifying a card number, or for containing key, PIN, or other encryption data. Barcodes 110 may comprise user credentials and may hide user information to humans. The information stored in the barcodes 110 may be encrypted for use with decoding algorithms, so as to be unintelligible to normal QR scanning devices. In some instances, barcodes 110 may be used or interacted with during system application functions and executions.

Cards 100 may comprise a magnetic stripe 111, such as high-coercivity HiCo devices, low-coercivity—LoCo devices. Cards may instead, or additionally comprise other data storage means which may be used with payment terminals, including, but not limited to a chip (e.g., integrated circuit, microprocessor, security authentication device, single sign-on SSO device, EMV chip, ISO/IEC 7816 device, contactless “smart” ISO/IEC 14443-compliant device, inductor-comprising device, straight memory 1 k-1 Mbit Flash EEPROM I2C/SPI device, protected/segmented memory 3 k to 64 kbit EEPROM device, stored value memory, 8-bit Symmetric key/file-based 8-144 kB EEPROM, 8/16/32 bit public key dynamic 8 k-1 MB EEPROM with math coprocessor, 125 kHz proximity read-only device, 13.56 MHz ISO 14443 0.5-8 kB read/write device, MiFare protocol device, proprietary protocol device, ultrahigh frequency gen 1 or 2 device, semiconductor, proximity locator chip e.g., ScenSor DW1000 by DecaWave, IEEE 802.15.4a-compatible wireless communication device, NFC-compatible chip), a solid state device, an RFID device (e.g., antenna, electromagnetic field device, tag, transponder, frequency modulating/de-modulating means, passive reader active tag device, active reader tag device, battery assisted tag BAT device, electronic product code EPC information, mobile computing communication device, virtual badge means, wireless tracking means, UHF inlays, smart labels, ultra strip 111 labels, theft prevention/security tag, electronic article surveillance EAS system-compatible tags), and other smart card features, without limitation.

Each card 100 may be provided with a unique system account number 112 (e.g., a gift card account number, a bank card account number, a frequent shopper card account number, a membership card account number, a credit card account number, a financial assistance/EBT card account number, a rewards card account number, a customer card account number, an escrow service card account number, a payment system account number (e.g., PayPal account number, merchant account number, acquiring bank account number, etc.). In preferred embodiments, the system account number 112 may be associated with a mobile device to serve as 2-part verification. Accordingly, in certain embodiments, a user must possess both the mobile device and card to utilize features of the mobile application and/or the card. Such embodiments may reduce the possibility of misappropriation of funds due to security flaws which may be present in mobile devices (particularly, from unsafe mobile applications containing malware). In certain embodiments, the system account number 112 may not be utilized for transactions, and instead, a function code 102-108 may be utilized. Accordingly, even if a text is intercepted, it may not be readily known to the interceptor which function the code pertains to—and the function may, in some instances, only be able to be utilized with the mobile phone associated with the function code 102-108. In this regard, the system account number 112 may not be used for online purchases or transferred to another card for fraudulent use at brick-and-mortar venues. Function codes 102-108, when used, may prompt the delivery of a one-time use password, PIN, passphrase, audio signal, or image (e.g., a machine-readable image), or a combination thereof to the user's mobile device, which may provide a layer of security and/or mitigate spoofing risks. In this regard, even if a hacker has a user's 10-digit phone or mobile device number and the user's function codes, and may provide the information to the system (e.g., via SMS/MMS protocol), the system may deliver a temporary one-time use password (OTP) or temporary one-time use instruction to the user's mobile device, which the mobile device user may respond to. An example of this may be an instruction to text a provided pin number to a particular short-code to authenticate a transaction. In some embodiments, a user may need to snap a picture of a barcode and text the snapped picture to an electronic address (e.g., a system electronic address) in response to a system prompt.

Cards 100 may comprise a protective security sticker or scratch-off material layer 113 which covers function codes 102-108 and activation pins. In some embodiments, a user may snap a picture of a barcode (e.g., a QR code) and text the image to a provided system number to activate the card and link the mobile device electronic address (e.g., 10-digit mobile number) to the card for later uses. In some embodiments, as shown, a user may call an indicated system number or text an indicated system number, address, or short code and provide an activation code 117 or PIN. The activation code 117 may be permanently provided to the card, or may be provided on a removable sticker which may be discarded after successful activation. At any point in time, a user may delete SMS/MMS threads from their mobile device, and/or purchase a new card if they feel the system has been compromised.

Although the system may be most advantageously suited with reloadable or non-reloadable prepaid debit and/or pre-paid gift cards having small card balances thereon (e.g., $50-$500), which may be used for making small “petty” transactions (e.g., token gifting purchases) when compared to credit and bank cards used to make much larger purchases, it should be duly noted that certain features, components, and or method steps associated with the system could be scaled and/or advantageously practiced or otherwise employed with conventional banking and credit cards and mobile banking applications associated therewith.

In some embodiments, the scratch-off material layer 113 may be provided on top of a revealed indicia layer 114 which is provided on top of a sticker 115, which may be adhered to a portion of the card 100. Alternatively, the revealed indicia layer 114 may be printed directly onto a portion of the card, and the scratch-off material layer 113 applied directly to the card via a masking technique. The sticker 115 may be removed from card and applied to a portion of a mobile device or other item for convenient access; however, such a practice may compromise the added security of requiring both the card and the mobile device to perform a transaction. The revealed indicia layer 114 may comprise the aforementioned unique system account function codes 116 (e.g., send funds code/address 102, request funds code/address 103, send item code/address 104, buy item code/address 105, “like” or provide a favorable opinion code/address 106, add to wish list code/address 107, recommend to a friend list code/address 108, request to see wish list code/address, request list of recent transactions code/address, see account balance code/address, report lost/stolen PIN code/address (for safekeeping on mobile device, paper wallet, or digital wallet), post to a profile code/address, etc., some of which are not explicitly shown in the drawings, but would be readily appreciated from this disclosure as a whole.

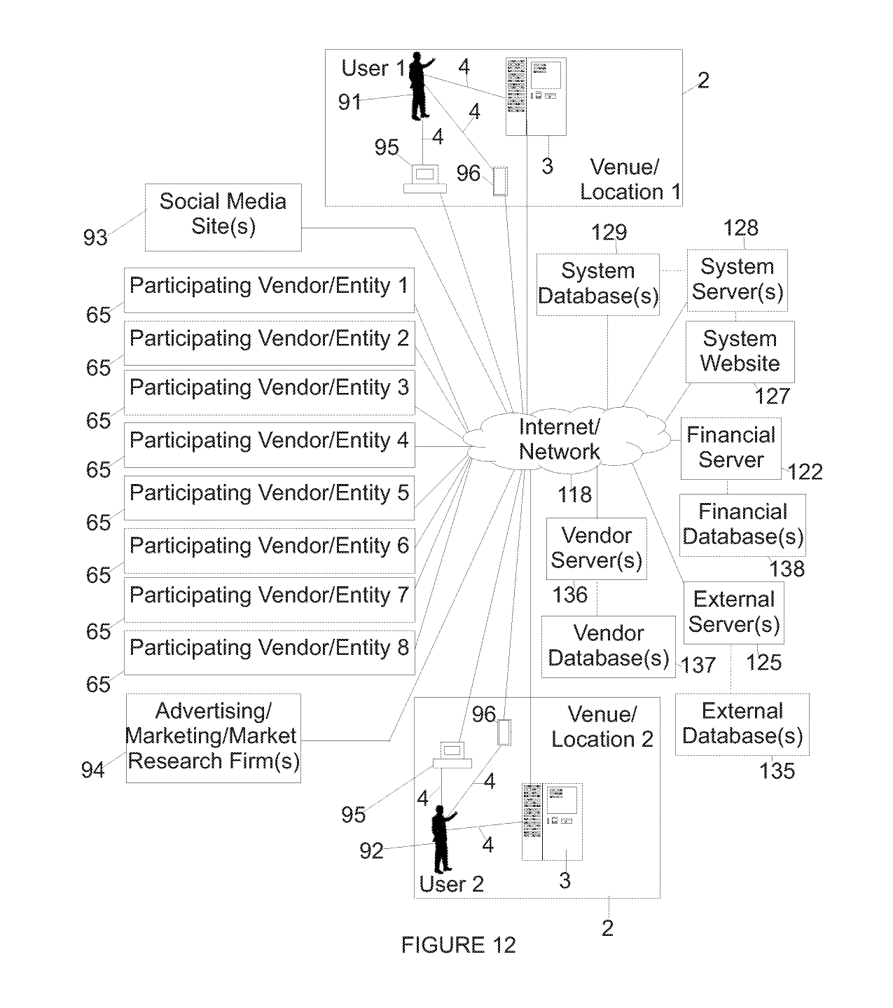

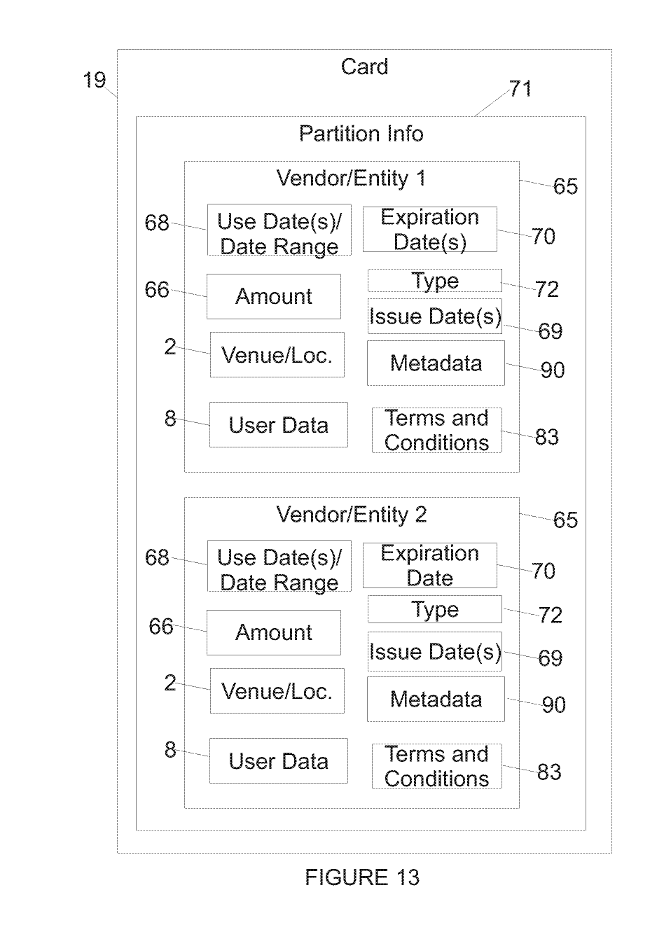

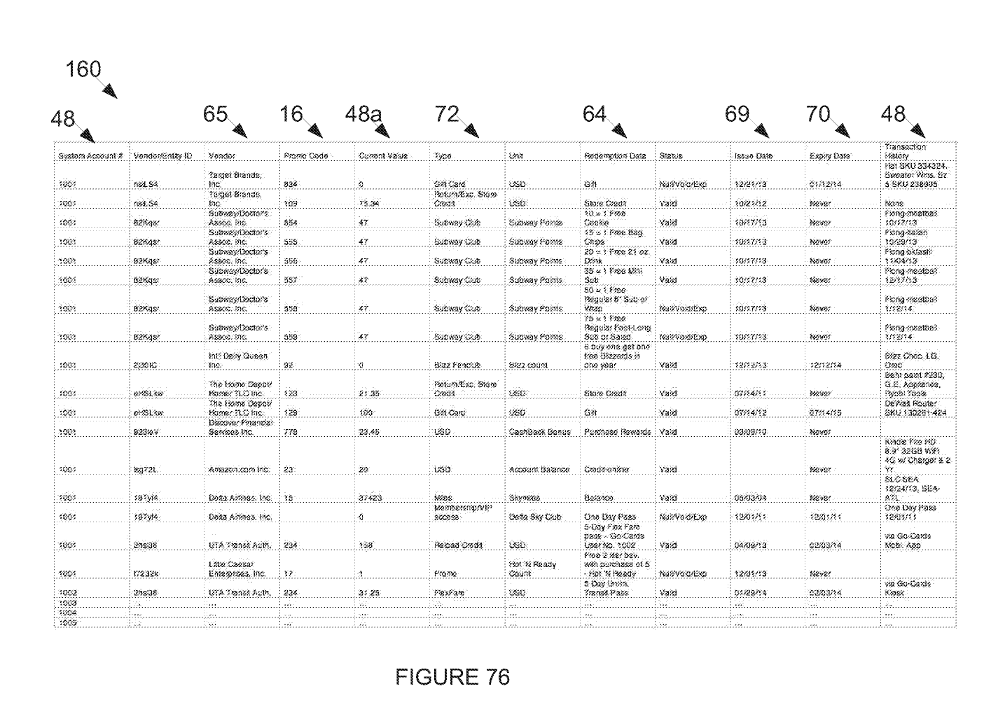

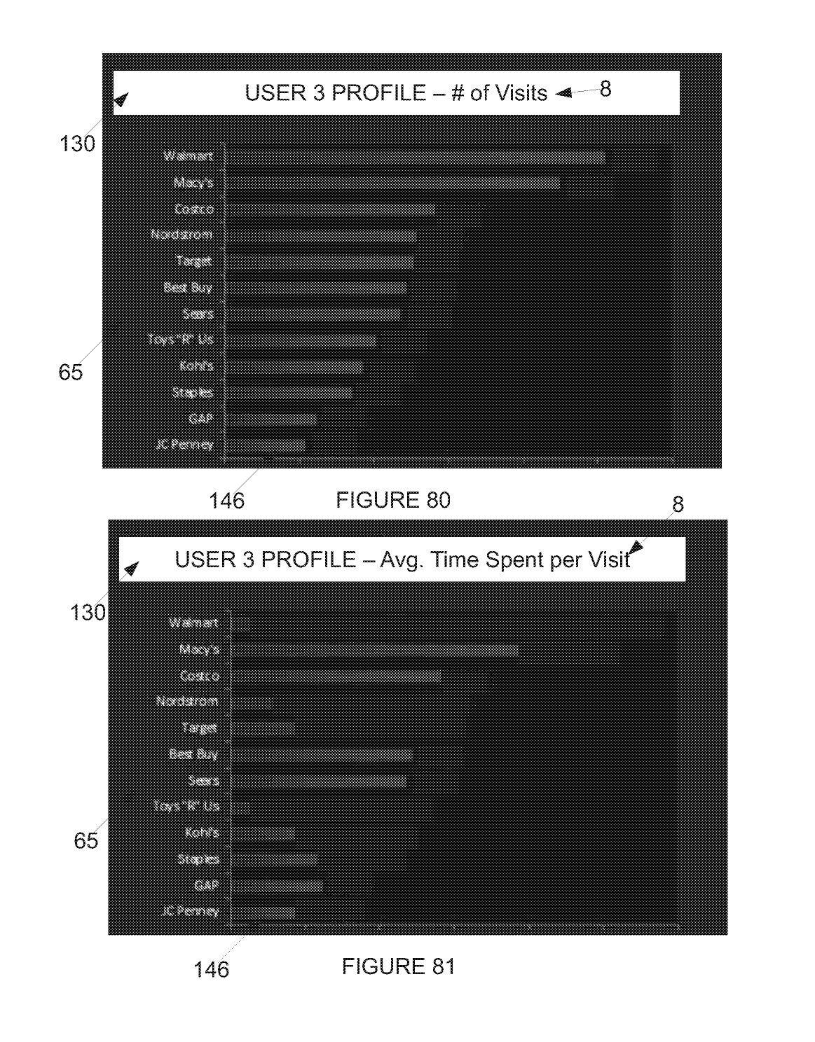

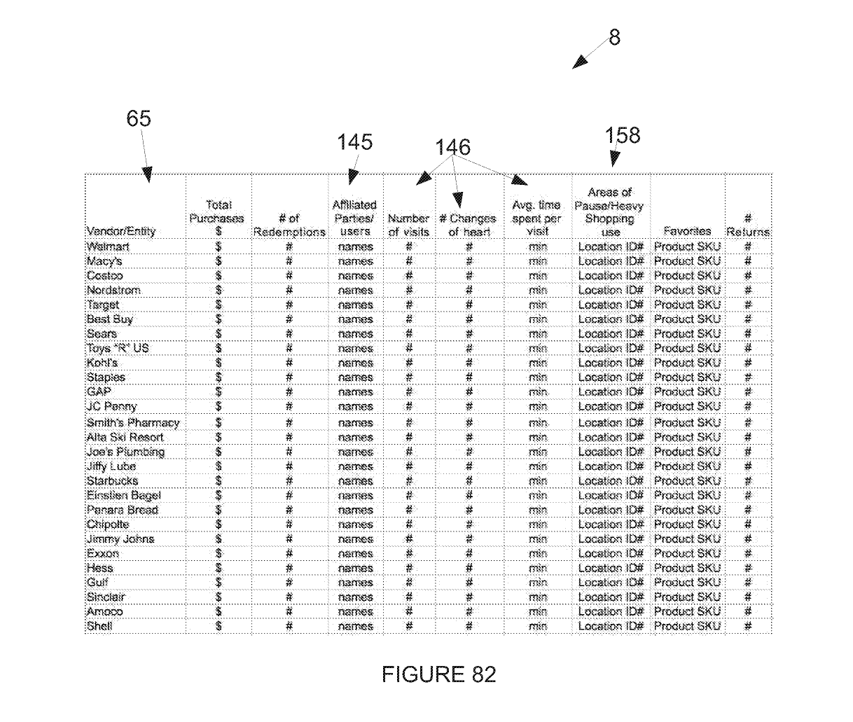

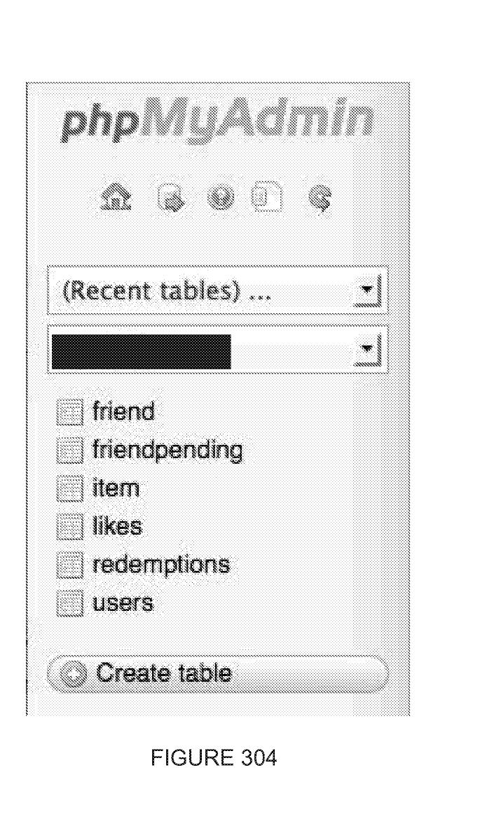

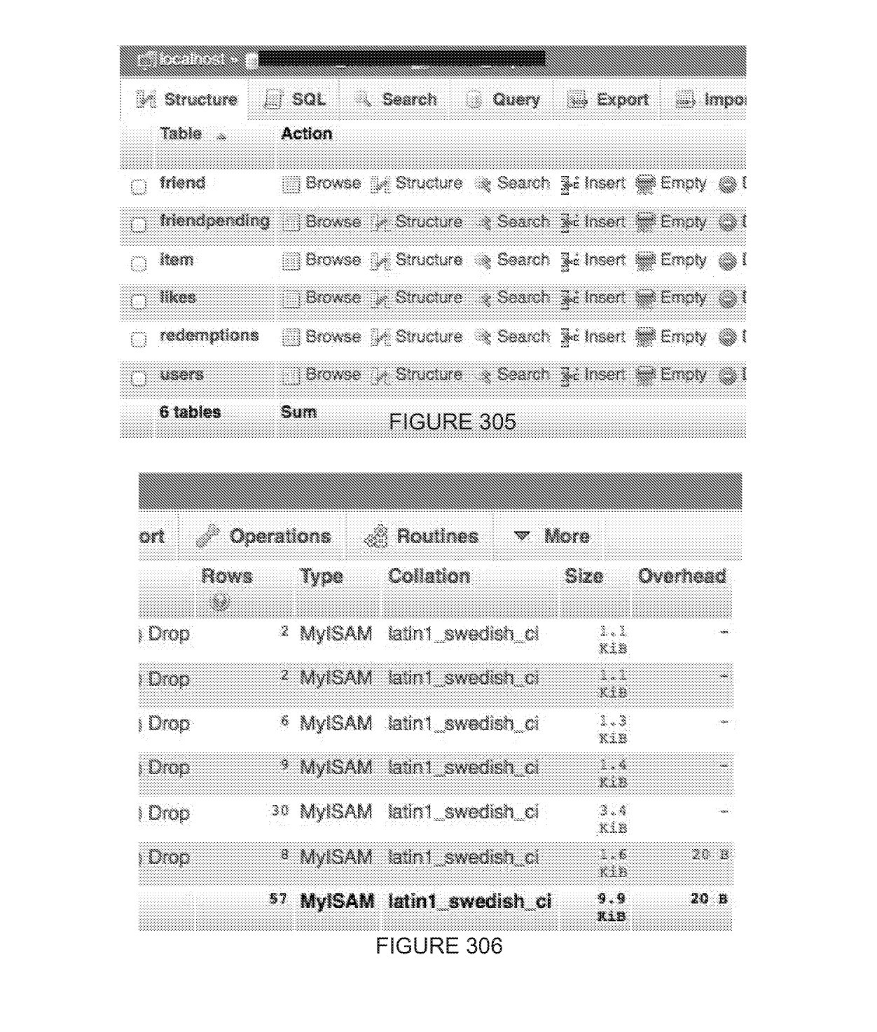

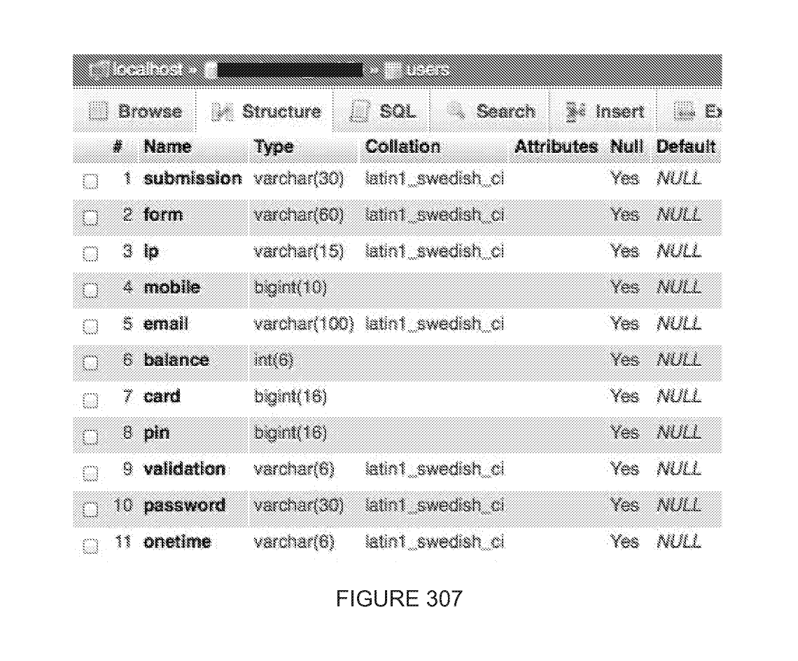

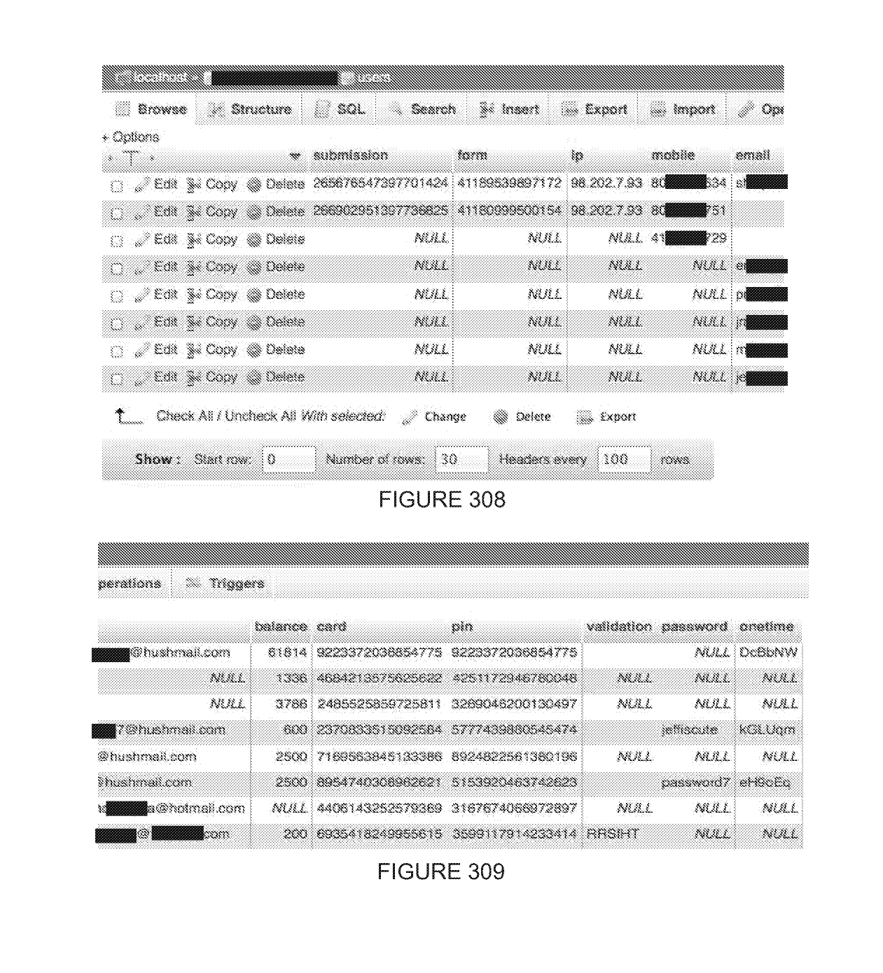

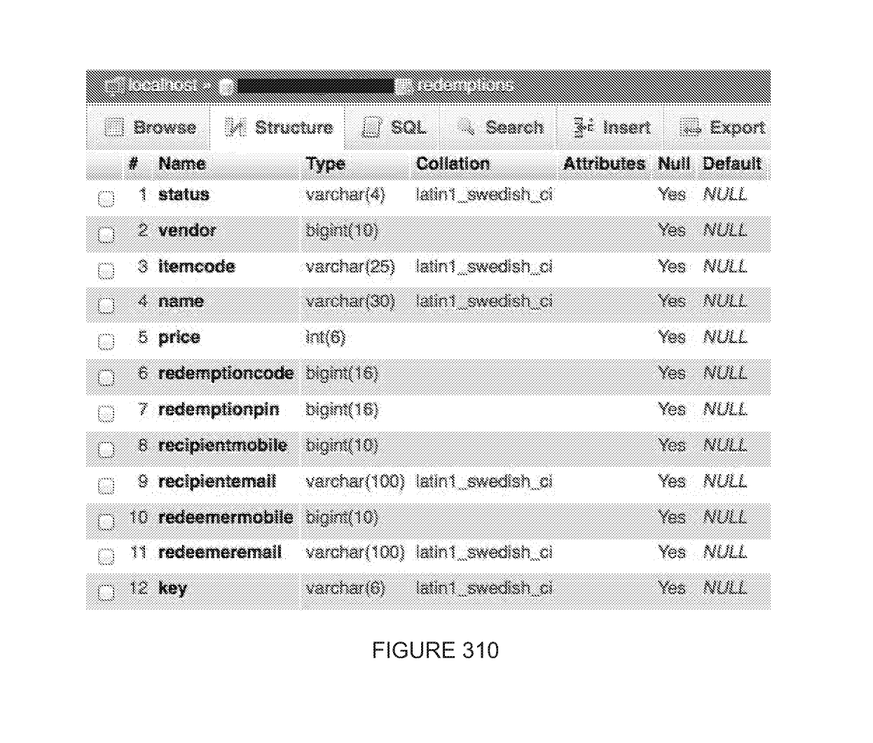

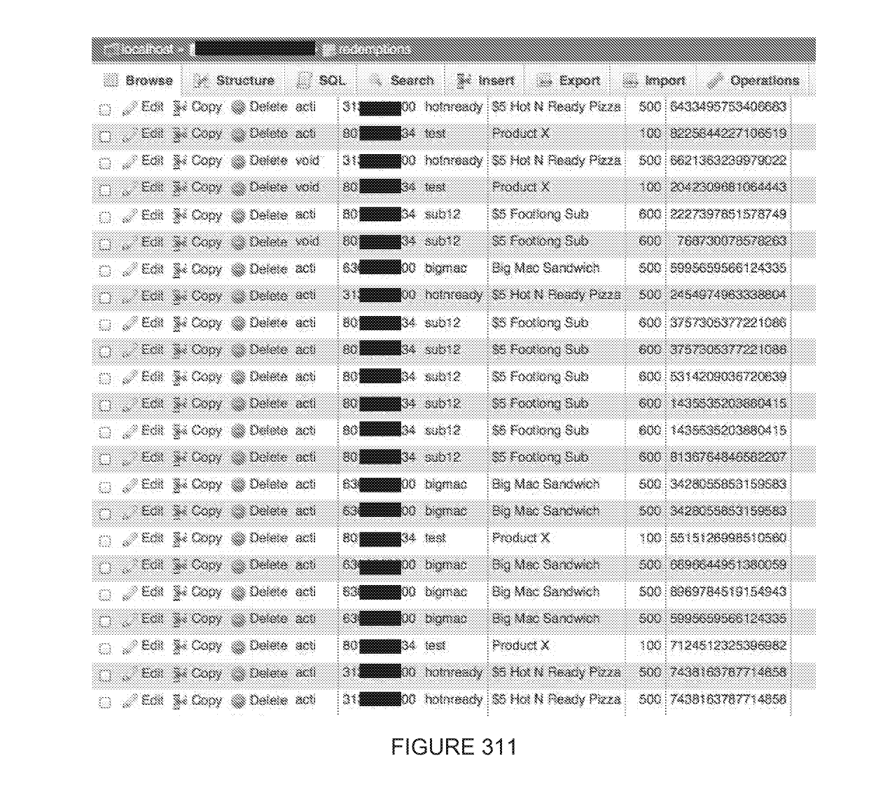

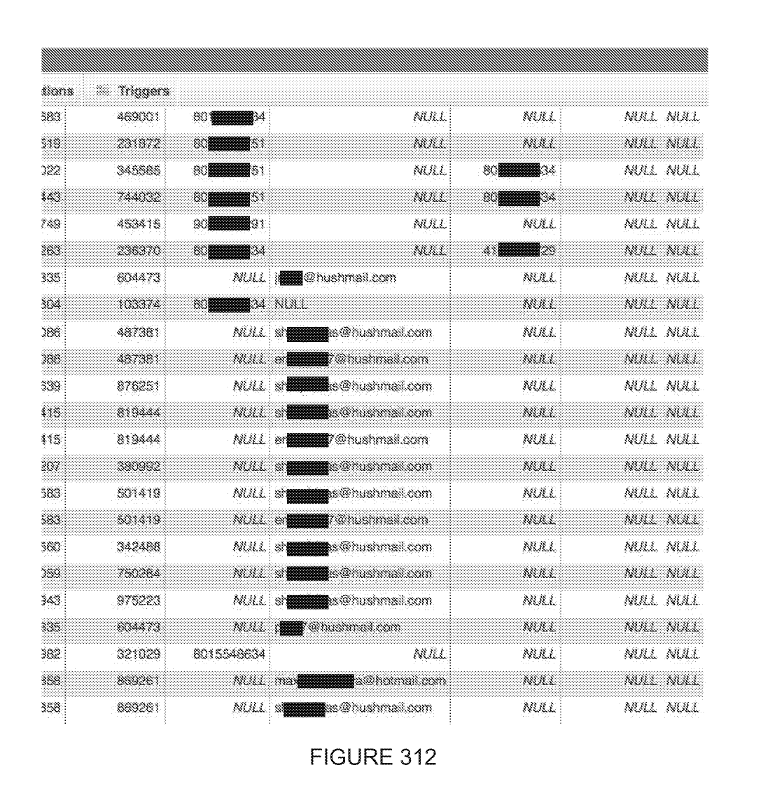

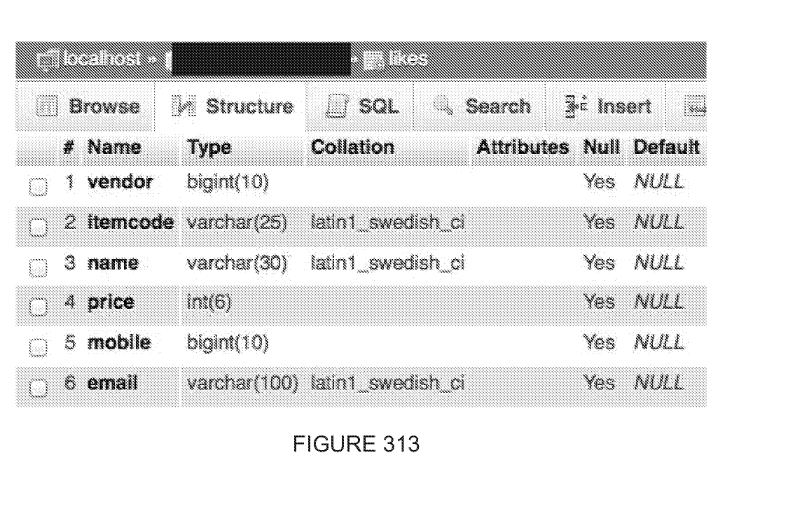

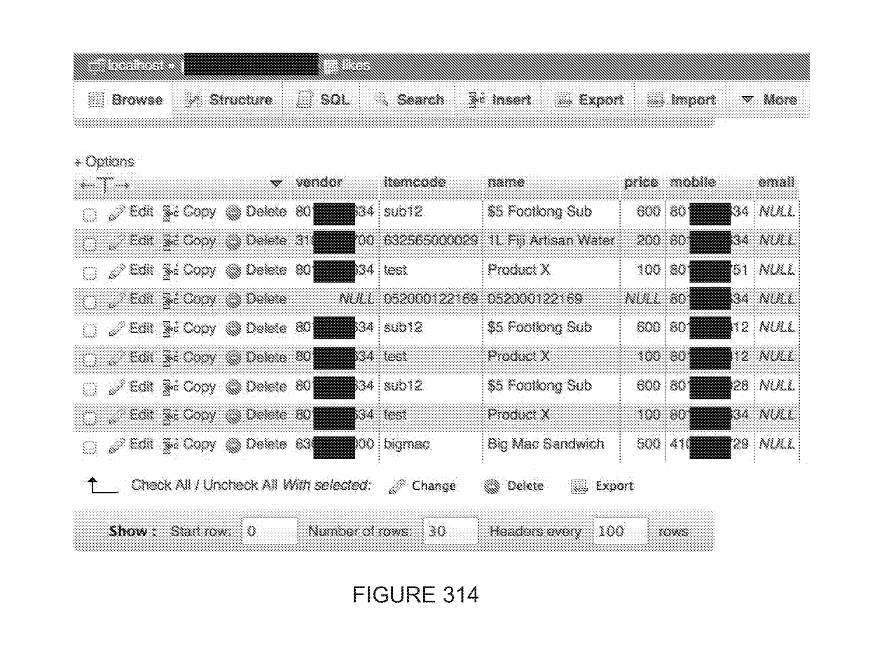

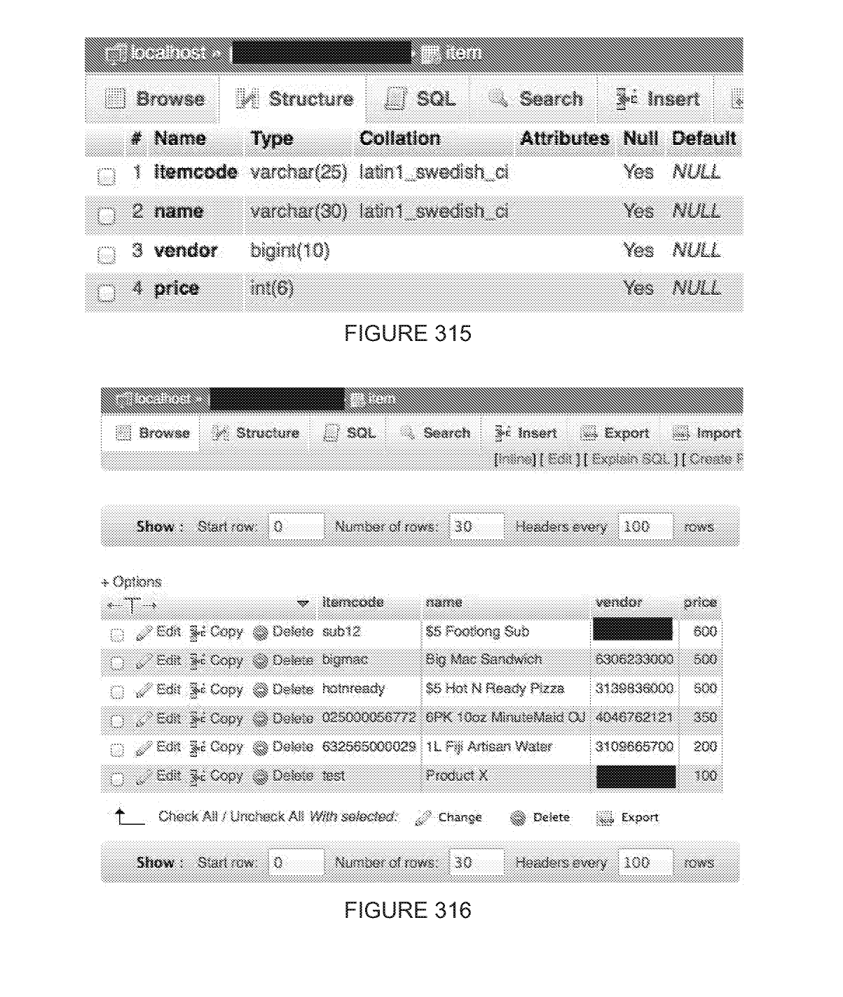

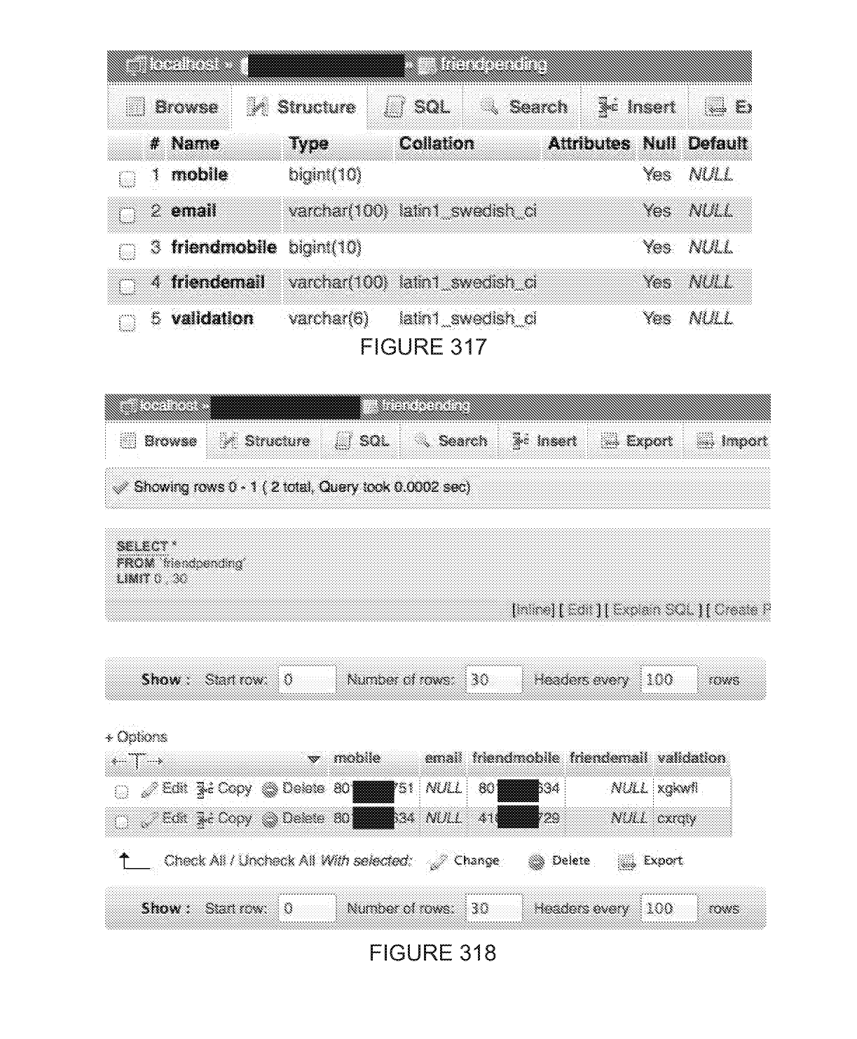

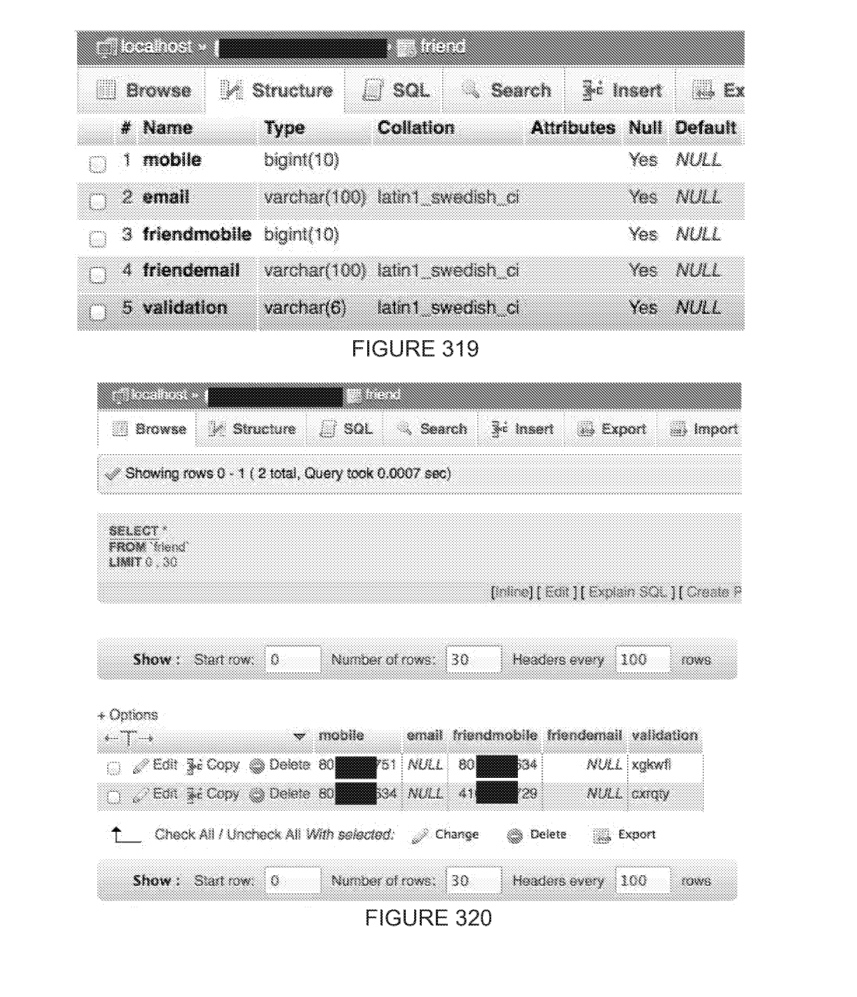

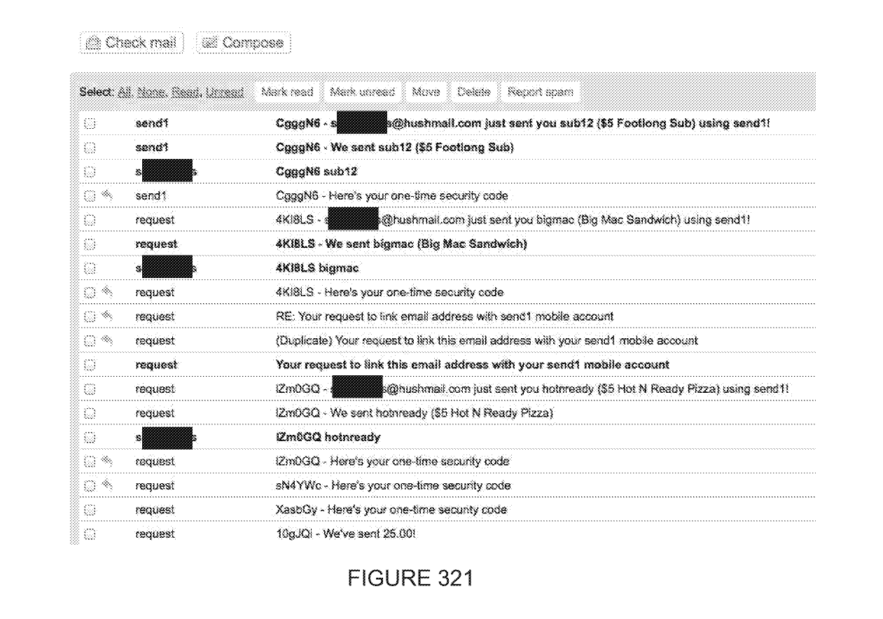

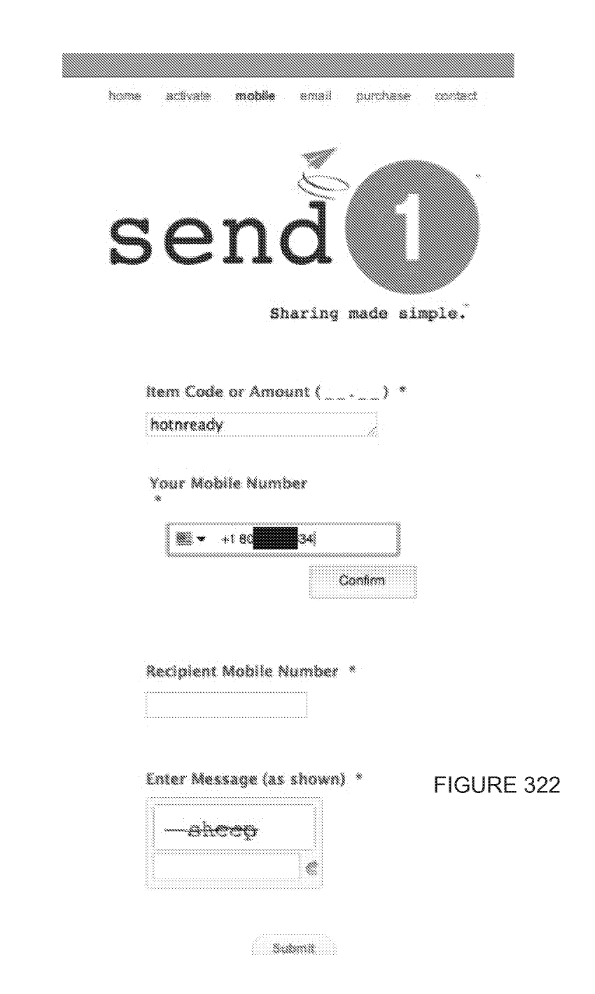

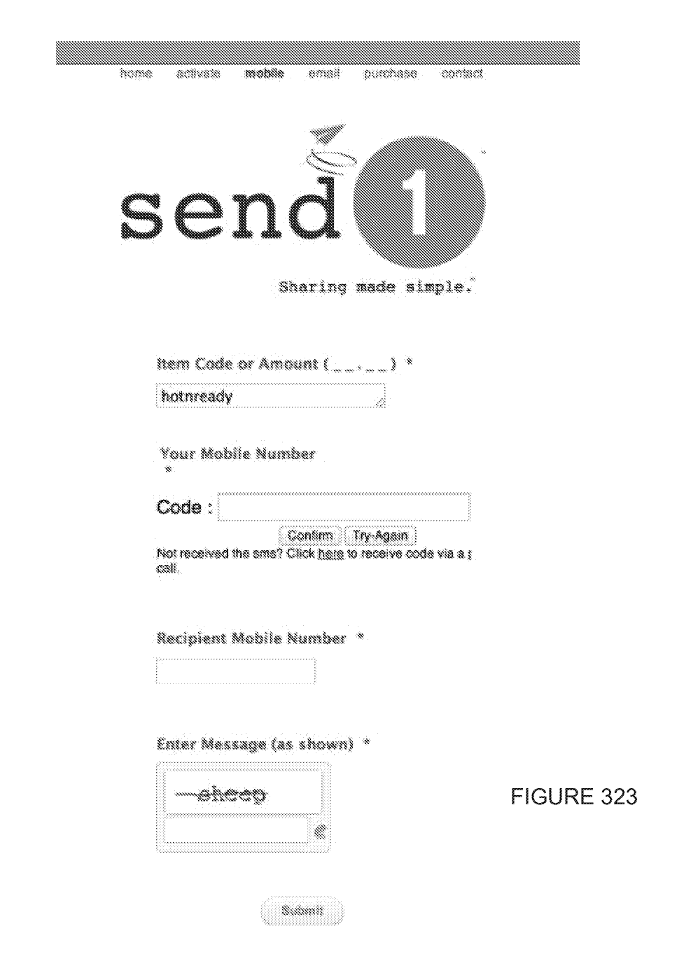

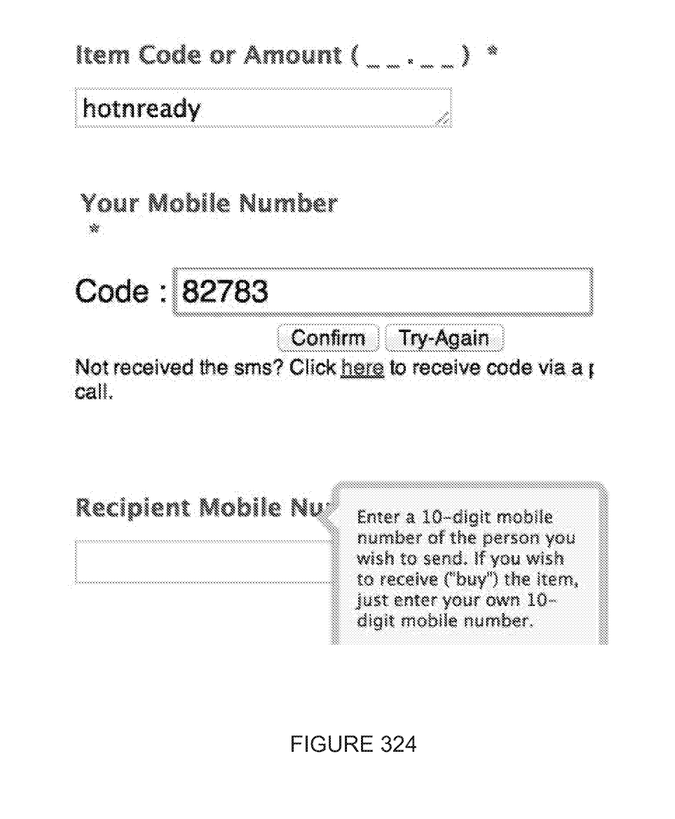

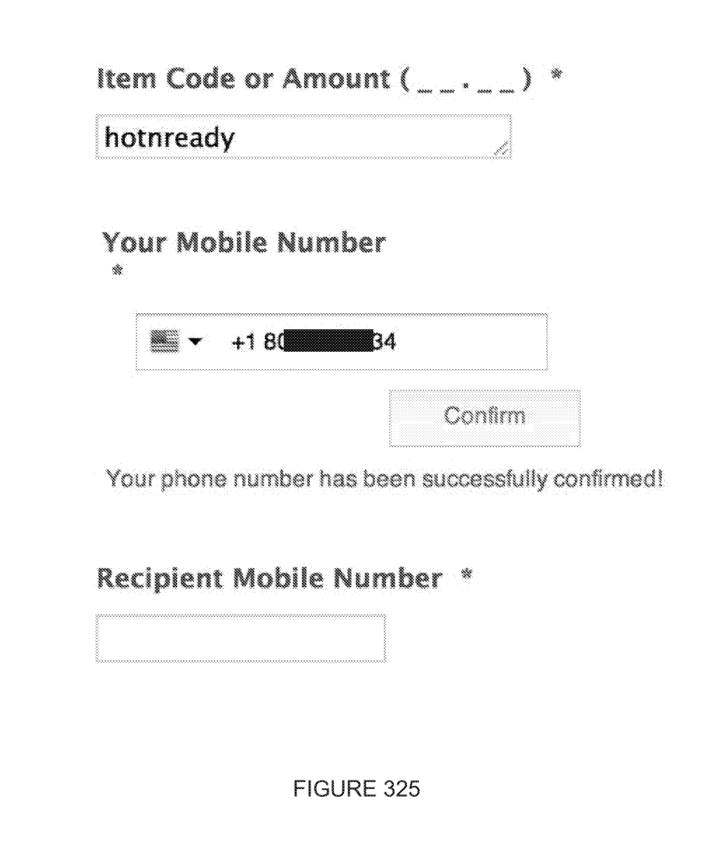

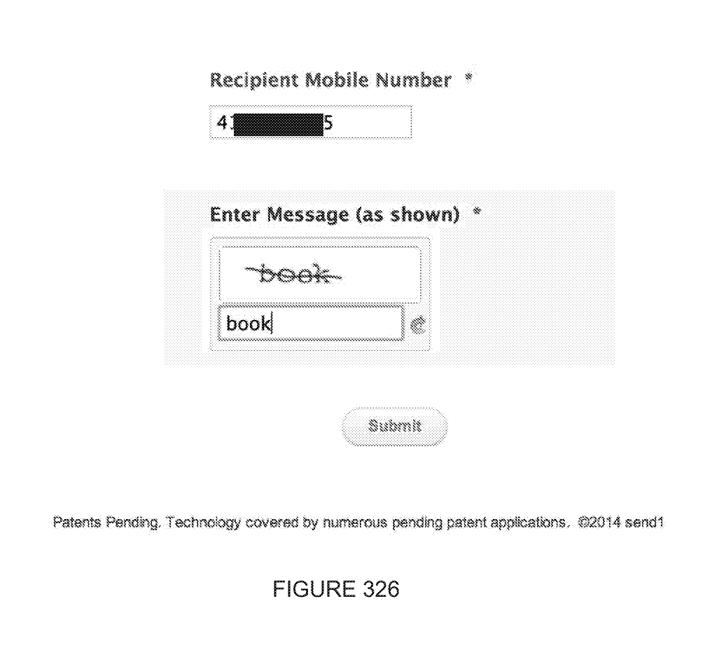

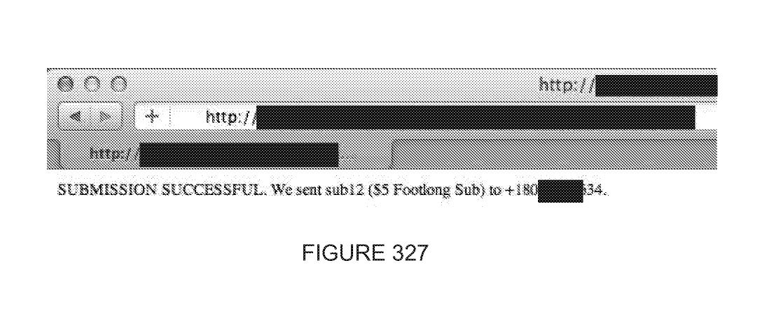

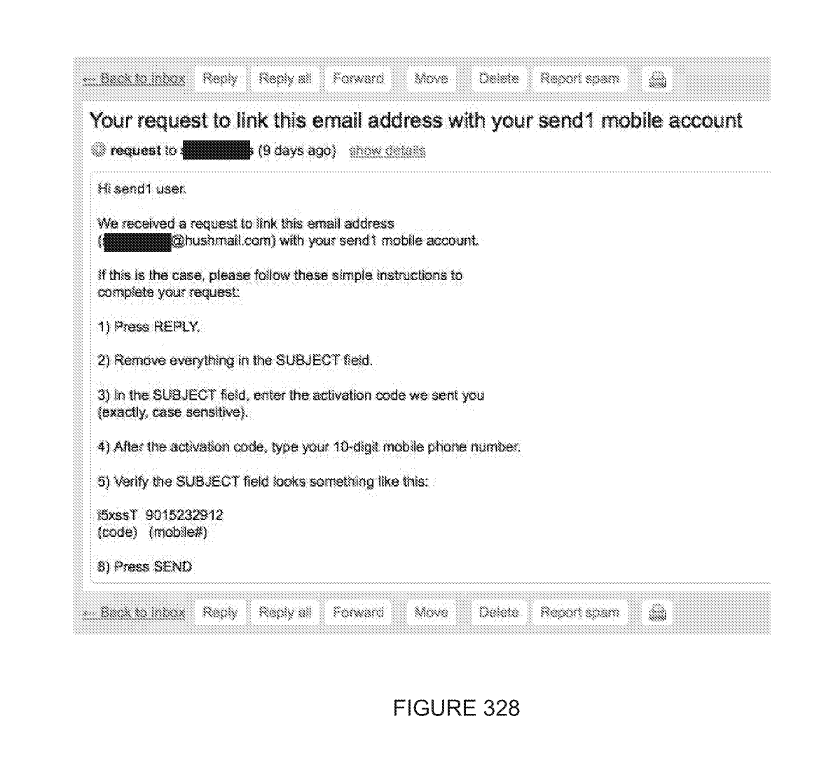

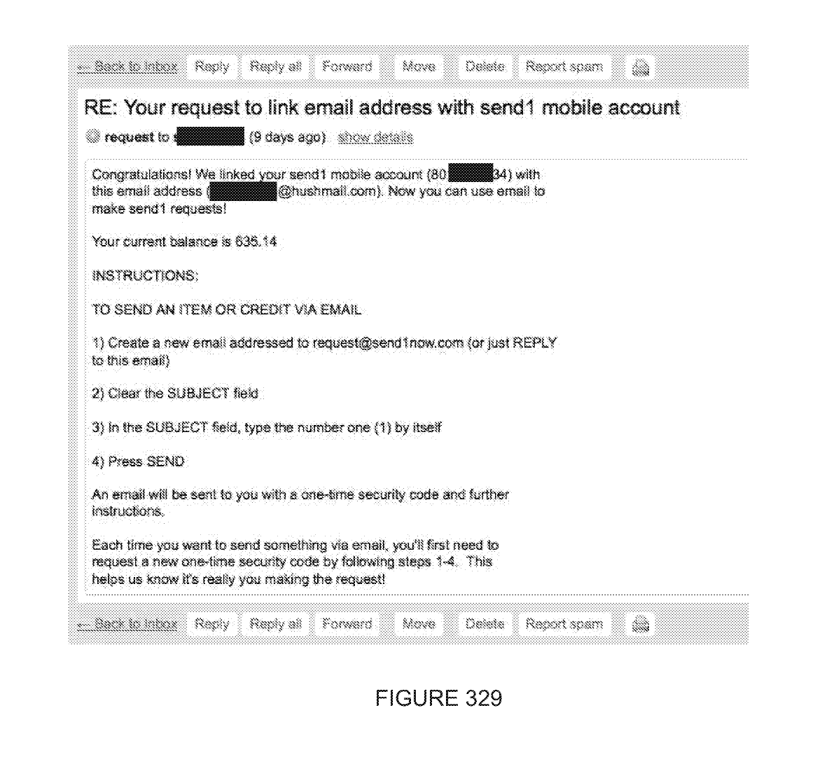

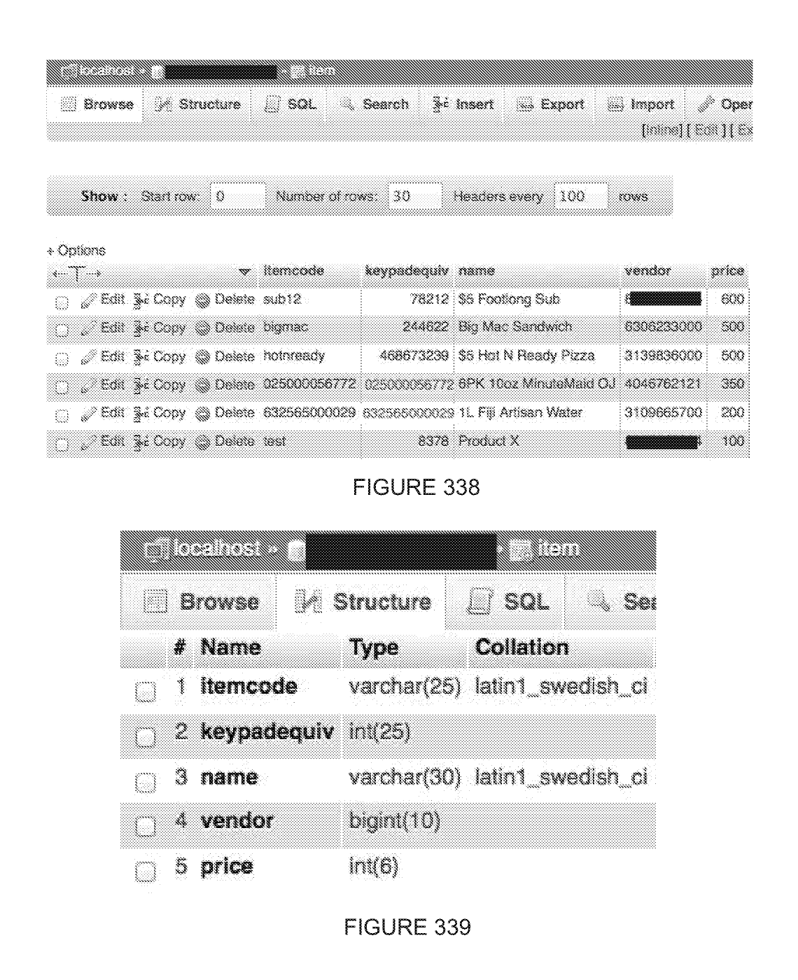

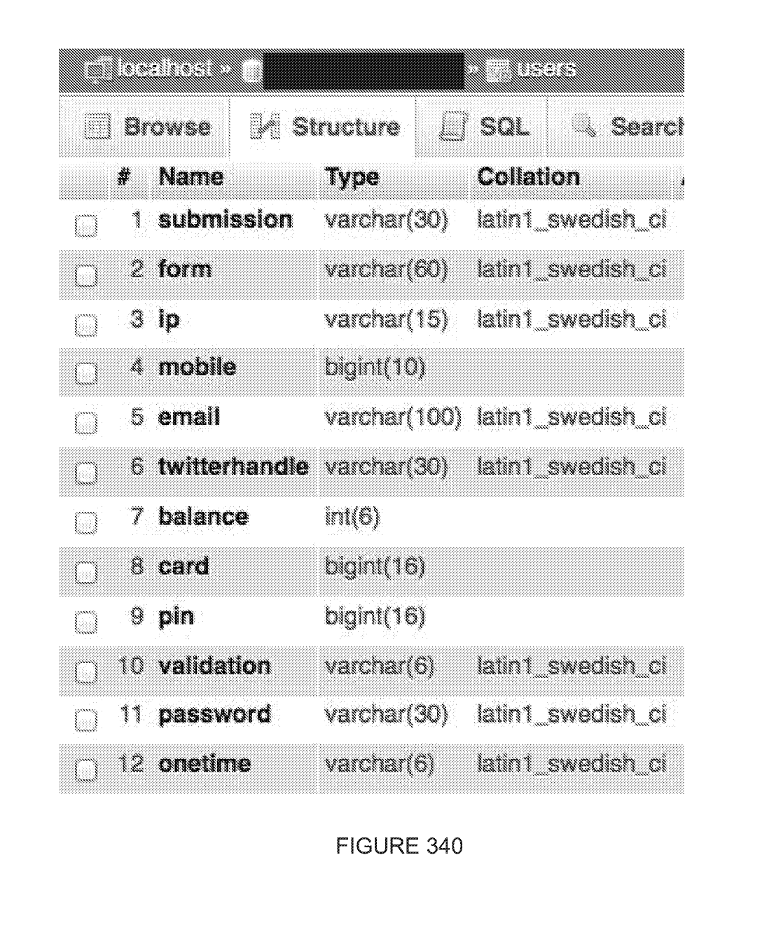

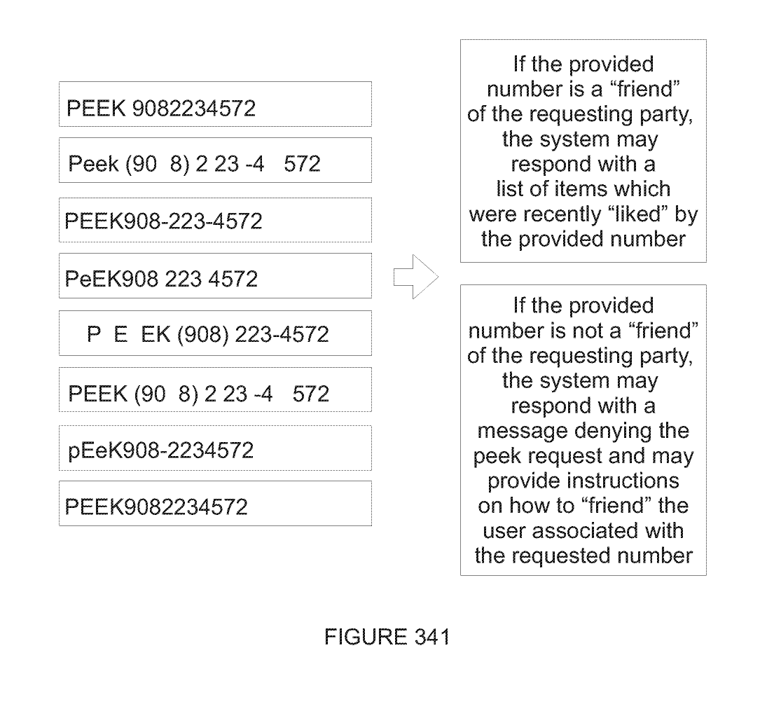

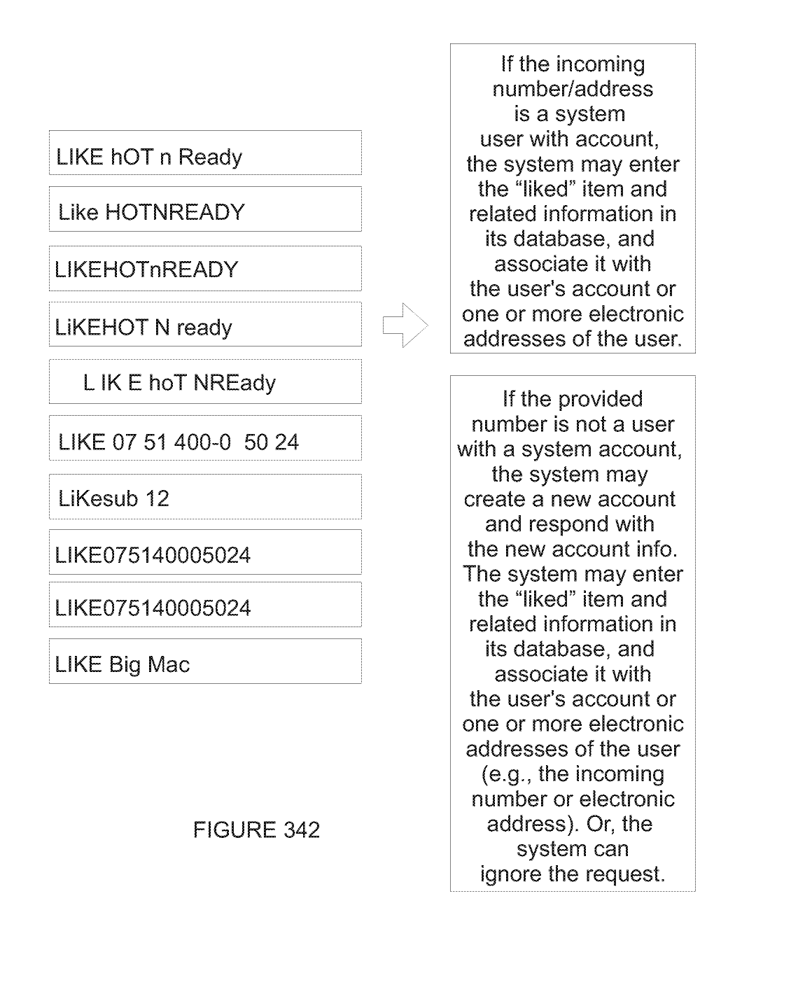

Turning now, to FIG. 12, and as will be further appreciated, the system may comprise one or more system servers 128 provided with one or more server computers or controllers, a system website 127 which may be maintained on the one or more system servers 128 or on an external server 125, and a system database 129, which may be maintained on the one or more system servers 128 or an external server 125. Non-limiting examples of database 129 contents may be found in FIGS. 76, 80-82, 120A-120E, 284-286, 304-320, and 338-340. The system may comprise proprietary software including mobile applications, and downloadable applications for use on system servers 128 or user computers. The system may be integrated with third party servers, applications, websites, databases, and the like as necessary to complete the tasks and functions discussed herein as will be appreciated by those having skill in the art. Such third-party components may include social media components such as modules, add-on software, portals, or gateways which allow system components to communicate with a social media server 93 and information associated therewith. In some embodiments, a user may link their third-party or non-system-based profiles 130′ by visiting the system website providing their phone number (and/or optionally providing indicia provided on the system card 100, such as the activation code 117, card number 112, or a function code 116), and logging into their third-party or non-system-based profiles 130′ with the appropriate login credentials. Alternatively, a user may access a system page affiliated with a third-party or non-system-based website associated with the third-party or non-system-based profiles 130′. Even more alternatively, a user may text their third-party or non-system-based profile 130′ account number to a system-provided number or short code. Yet even more alternatively, a user may call a system-provided number and enter, when prompted, their third-party or non-system-based profile 130′ account number or profile ID using a keypad on their phone or mobile device. In this regard, users which may not have smart phones may still be able to perform social network functions such as “LIKE”-ing, sharing, posting, and “TWEET”-ing with the convenience of a text message.

The system may communicate with advertising or marketing agencies and vendors/selling entities alike, primarily to load system databases 129 with redemption information which may be used to send pre-formatted messages to users, and to allow users to make transactions, such as purchase, receive, and deliver items to other users. Use of such information may be appreciated from the figures without limitation. To facilitate this, system components, such as a system server 128 controller, may be networked with or otherwise have access to communicate with advertising or marketing agency servers 94 and/or vendors/selling entity servers 136. Alternatively, the system website 127 may have means for vendors/selling entities and/or advertising or marketing agencies to set up a profile, log in, and upload, maintain, and update redemption option information directly to system databases 129. In this regard, if a redemption option is expired, or otherwise not found in the database (e.g., NULL or “expired” or “0”), the system may auto respond to the sending user, notifying them that the redemption option is no longer valid.

For example, a Domino's pizza representative or employee may log into the system website 127, access their data entry page, and upload a first redemption option (e.g., “9184” for “1 Medium 2-Topping Handmade Pan Pizza” at a cost of “$7.99 USD”), a second redemption option (e.g., “5129” for “1 Large 2-Topping Pizza and Domino's Stuffed Cheesy Bread” at a cost of “$14.99 USD”), and a third redemption option (e.g., “9136” for “Any Large Specialty Pizza” at a cost of “$12.99 USD”). The item numbers may be populated into a system redemption option database 129. To avoid overlap with other vendors/selling entities, and/or to make codes a uniform number in length, the system may appoint a vendor/selling entity prefix code, or suffix code, or otherwise add characters to the vendor-recognized code e.g., “DOM11119184”, “DOM11115129”, and “DOM11119136”; or “9184DOM1111”, “5129DOM1111”, and “9136DOM1111”. The system may generate a unique barcode and/or redemption code and/or PIN which is to be used by a recipient of a purchased redemption option. The system may provide the vendor or selling entity with this information, and the entity may update their own systems to recognize the system-generated unique barcode and/or redemption code and/or PIN. When a user completes a purchase of a redemption option, (e.g., spends $14.99 USD worth of card 100 credit to send 1 Large 2-Topping Pizza and Domino's Stuffed Cheesy Bread to a friend or mobile contact by providing a recipient 10-digit mobile device number or email address, item number “DOM11115129”, and appropriate “send item code” to a system-provided number or address—by text or by entering similar information using an automated phone system), the recipient receives the respective generated unique barcode and/or redemption code. The recipient may show or present the information to a vendor/selling entity associate to redeem the redemption option and pay the appropriate local taxes, fees, or surcharges.

In some preferred embodiments, each unique barcode and/or redemption code generated by the system is unique for a particular transaction. However, the redemption code may be universal or reused for multiple system users. In such circumstances, to prevent mass forwarding or sharing the received redemption item with others, a unique PIN may be provided to the recipient via SMS/MMS messaging, to the recipient's mobile device upon redemption (i.e., a one-time password (OTP) may be sent to the recipient when the redemption option is ready to be redeemed). The one-time password may be one of a plurality of valid passwords which are pre-sent to the respective vendor/selling entity. The one-time passwords may change every day or every few hours. The vendor/selling entity may receive the valid passwords for the day or time period, and employees operating the P-O-S terminal may be told the passwords at the beginning of the shift for reference, in the event a user of the system wishing to redeem a prepaid redemption option wishes to utilize the credit during the day or time period. In some embodiments, due to the sometimes slow nature of store and forward SMS/MMS transmissions, or bad reception, the recipient may be instructed to request the one-time password well in advance of redemption. For example, a recipient of a pre-paid redemption option, upon receipt of the pre-paid redemption option, may be instructed to text a message, phrase, picture, or card indicia to a unique short code within a predetermined time period before redemption. If the user is a card holder, the user may swipe, scan, or tap the card to the vendor/selling entity's EFT terminal, and may be sent a one-time 4-digit pin to be used on the EFT terminal provided at the vendor/selling entity. In this regard, the card 100 associated with the electronically-delivered redemption option is required to take advantage of the credit. In certain embodiments, all three of the user's card, the redemption option information, and a one-time pass code (OTP) may be necessary to redeem a pre-paid electronically-delivered redemption option. Of course, it is anticipated that existing conventional methods and protocols for redeeming, verifying, and/or accepting eGift certificates (e.g., delivered by email) may be employed without limitation.

Financial servers 122 may be integrated with the system or otherwise form components of the system. For instance, financial institutions may be partners of the system and participate in the manufacture and/or issuing of cards 100, and may require access to or maintain the system database 129. Financial institutions may be used by the system to store or deposit funds/credits received by users and withdraw funds/credits to make users 91, 92 and/or vendors/selling entities whole. Financial institutions may support and/or maintain the system server 128, website 127, and/or database 129, and may utilize components of the system and/or perform system functions, or manage the system entirely by piggy-backing off of existing pre-paid credit/debit card platforms.

Unlike traditional gift cards, a first card 100a may be owned, held, and used by a first user 91, but used to gift to a second user 92 or other user, and/or used as a traditional personal money card for personal use by the first user 91. The first card 100a may be linked to the first user's 91 mobile device 96a. The first card 100a may be used in conjunction with the mobile device 96a of the first user 91 to gift items electronically, or send funds or credits to the second user 92 via a mobile application or more preferably, via SMS/MMS messaging protocols. A second card 100b may be owned, held, and used by a second user 92, but used to gift to a first user 91 or other user, and/or used as a traditional personal money card for personal use by the second user 92. The second card 100b may be linked to the second user's 92 mobile device 96b. The second card 100b may be used in conjunction with the mobile device 96b of the second user 92 to gift items electronically, or send funds or credits to the second user 92 via a mobile application or more preferably, via SMS/MMS messaging protocols. In preferred embodiments, the cards 100a, 100b provided by the system may be conveniently used universally with EFT terminals as does pre-paid VISA, MasterCard, Discover, AMEX, and other financial institution-issued cards. In other proposed embodiments, the cards 100a, 100b may not be affiliated with a major credit card company or bank, and may be used for proprietary or novelty purposes, for system functions, for third-party functions, for gifting purposes, or for making purchases and transactions with a particular vendor/selling entity; wherein the cards 100a, 100b may or may not have the capability of being used universally by EFT terminals as does pre-paid VISA, MasterCard, Discover, AMEX, and other financial institution-issued cards.

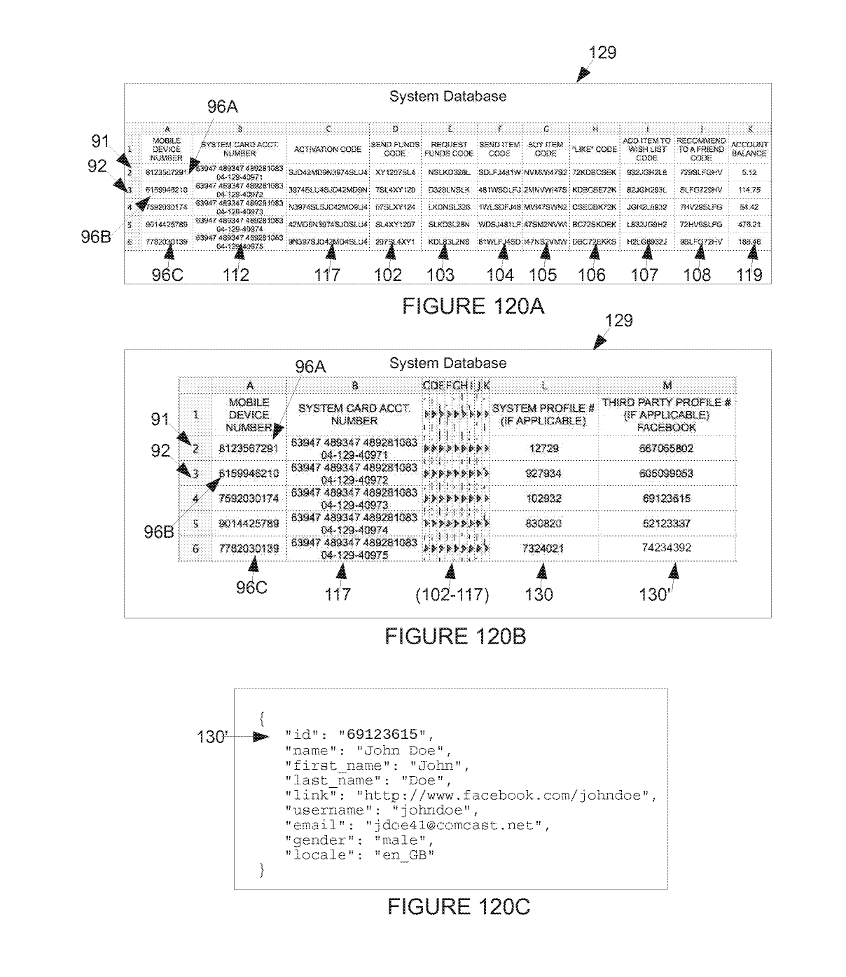

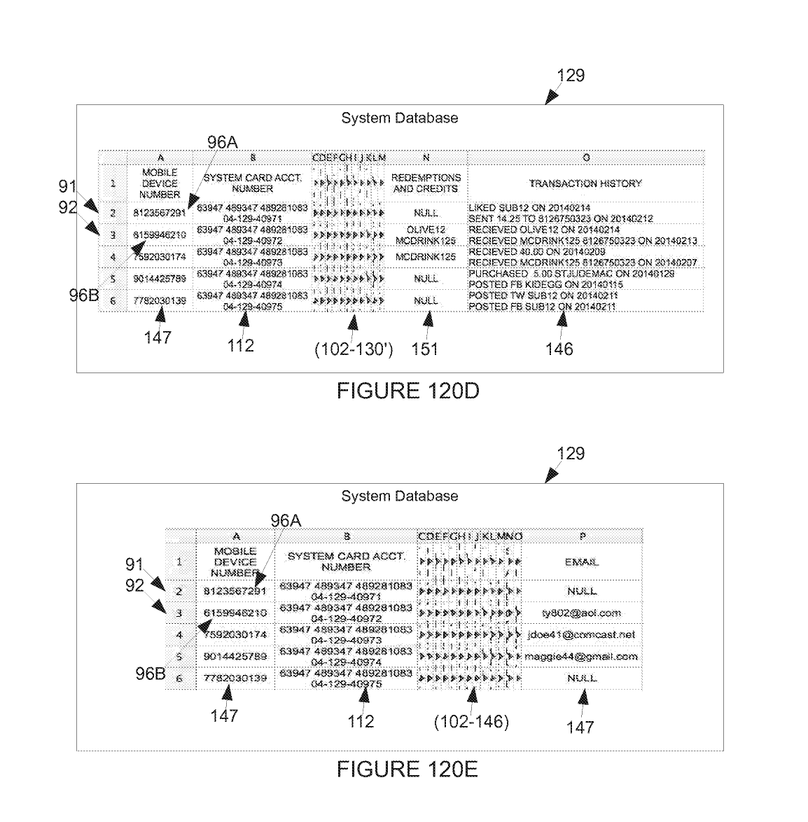

FIGS. 120a-120e suggest some non-limiting types of information which may be incorporated in a system database 129. To facilitate transactions, portions of the database may be accessed based on the incoming user's 10-digit mobile device number (although it is anticipated that for countries outside the United States, different length mobile device numbers may be utilized in a similar fashion). If the incoming 10-digit mobile device number is found within the database 129, the particular function code 116 accompanying message to the system may be checked to see if it matches the function code 116 in the system database 129 affiliated with the system account number 112 connected with the incoming 10-digit mobile device number. If so, the system may begin performing the requested function associated with the delivered function code 116. For example, if a “send item” code is attached in a message received by the system from a system user 91, along with the requested item number and recipient address (e.g., 10-digit mobile device number or email address of the recipient), then the process of sending the item to the desired intended recipient and reducing the requesting user's account balance by the appropriate amount is commenced. Each function associated with a function code 116 may begin executing code for automated delivery of previously “canned” messages. The canned messages may comprise blank templates which are automatically populated with redemption data information stored within the system database 129, or an external database 125, 93, 94, such as a database maintained by the respective vendor or selling entity affiliated with the redemption data/purchased redemption option. Autodialers, SMS gateways, API's for automated SMS/MMS may be employed by the system to facilitate such communications to the appropriate requesting user 91 and/or recipient users 92 of the system. Whenever certain information is provided by a user 91, 92 of the system, the information may be populated within the database 129 as conventionally done in commerce.

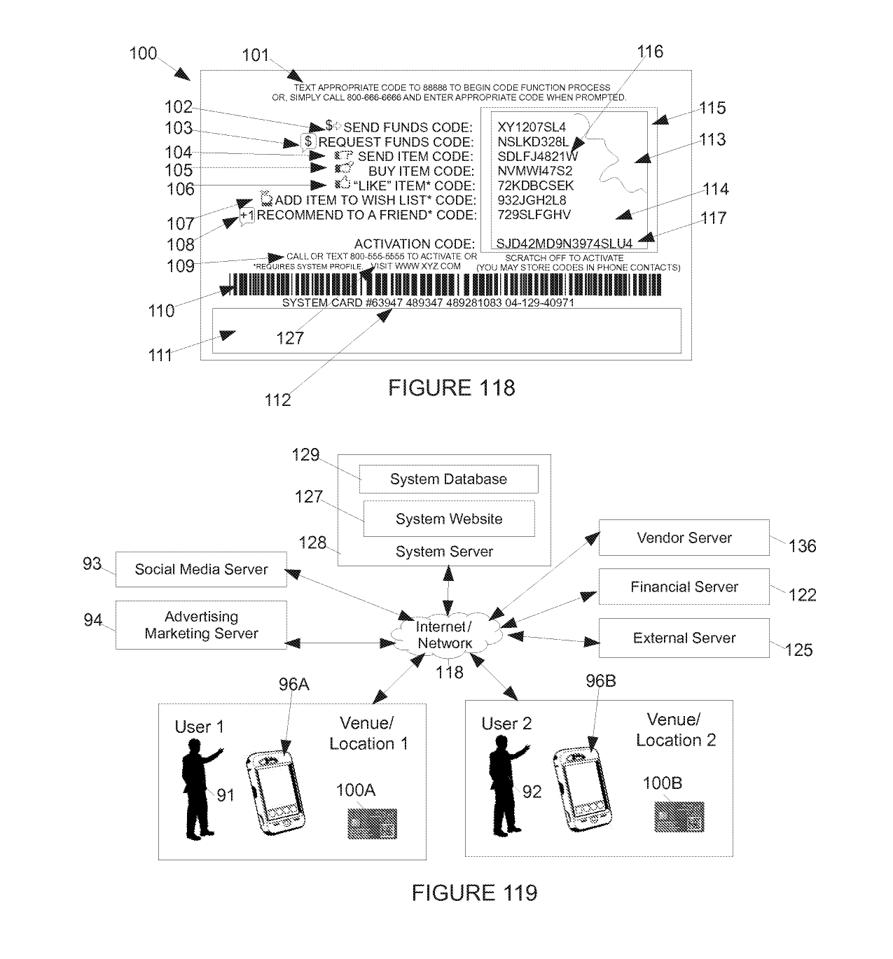

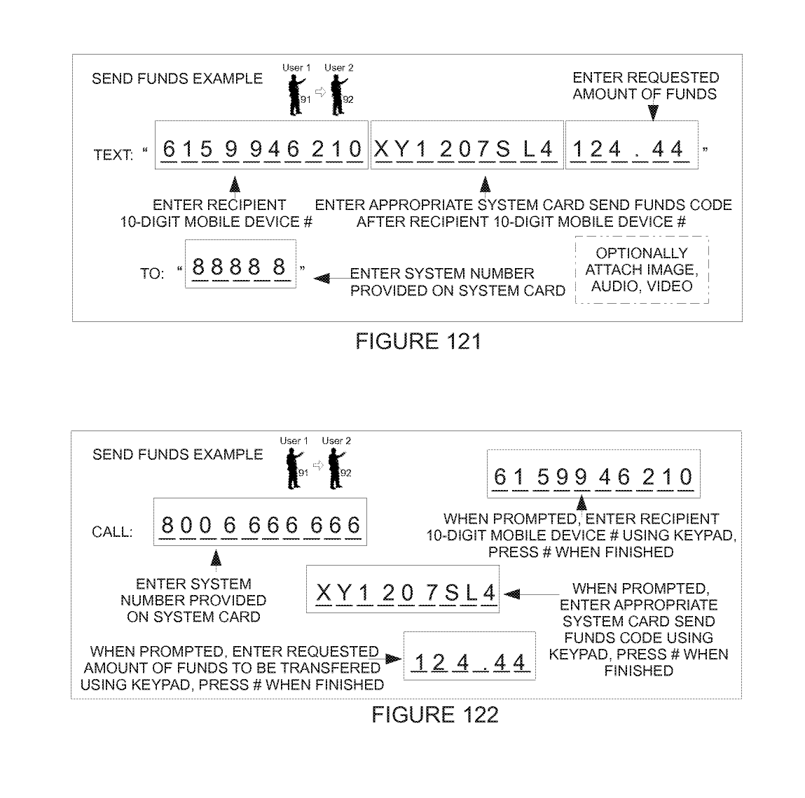

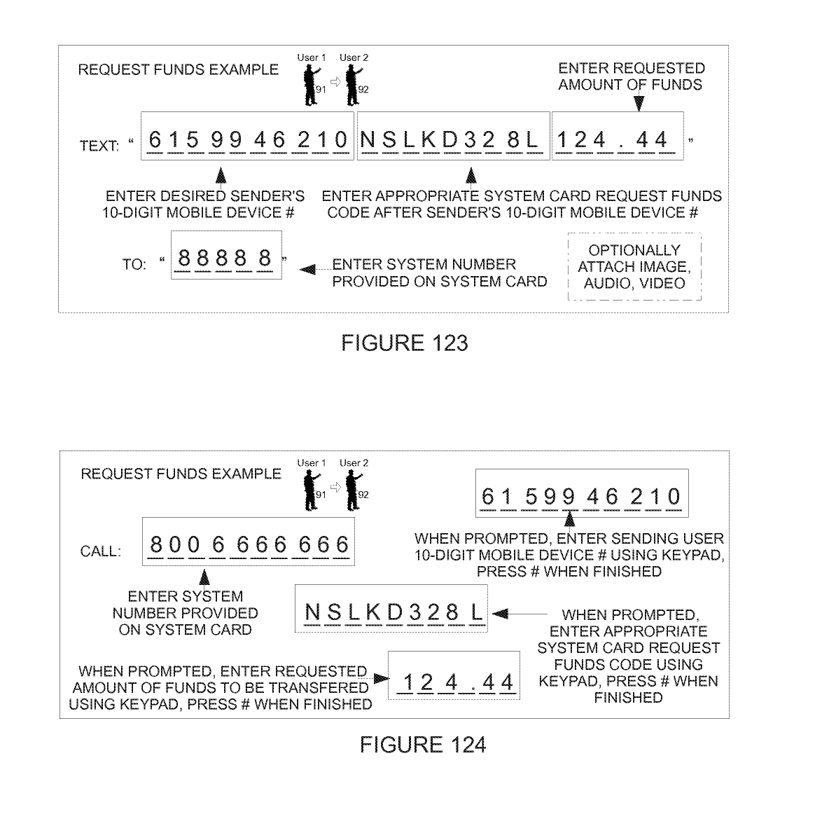

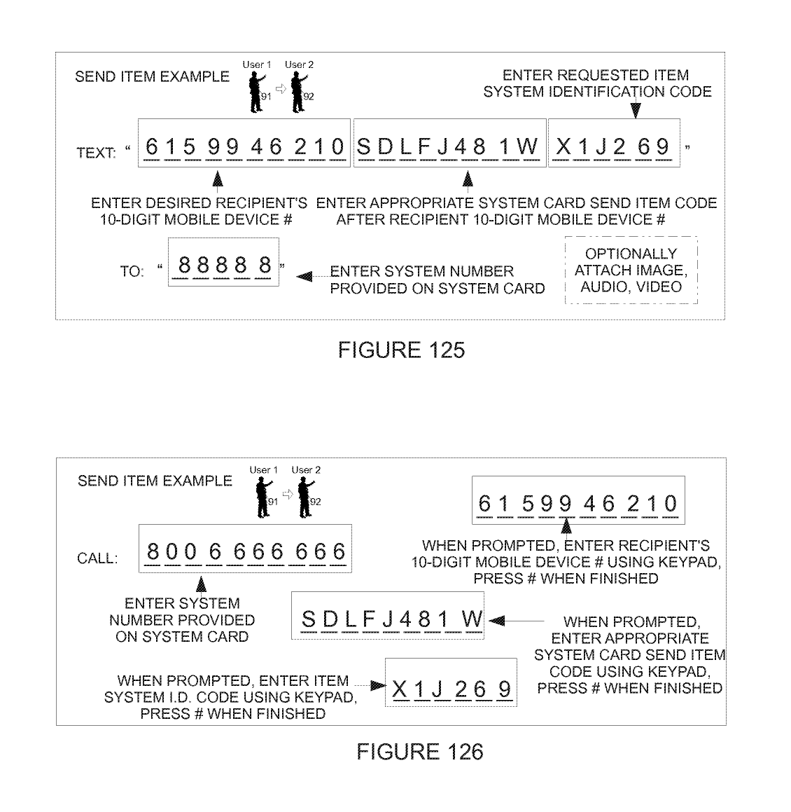

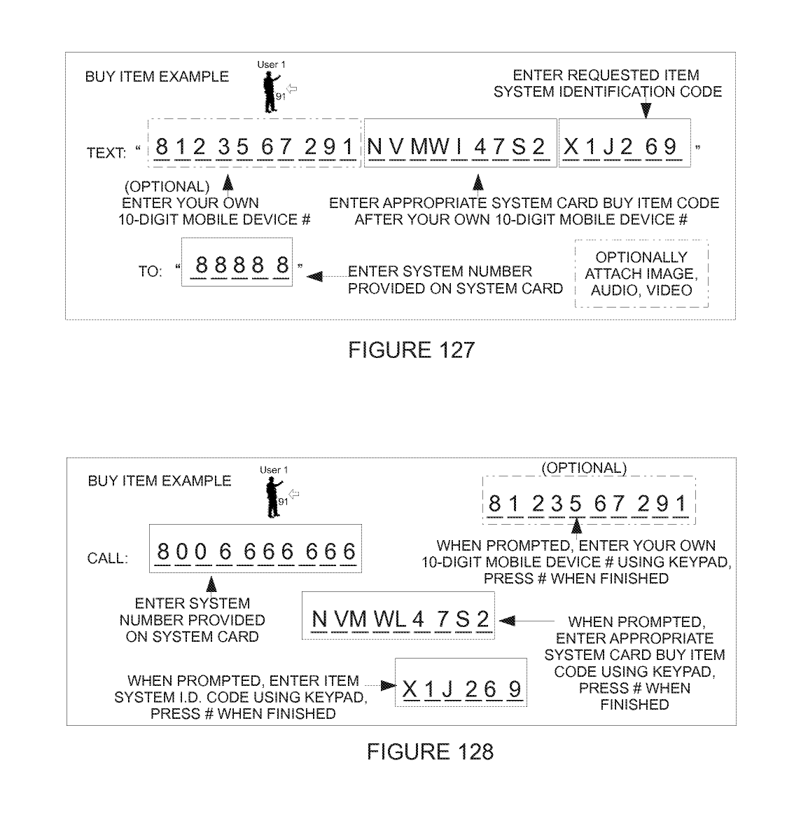

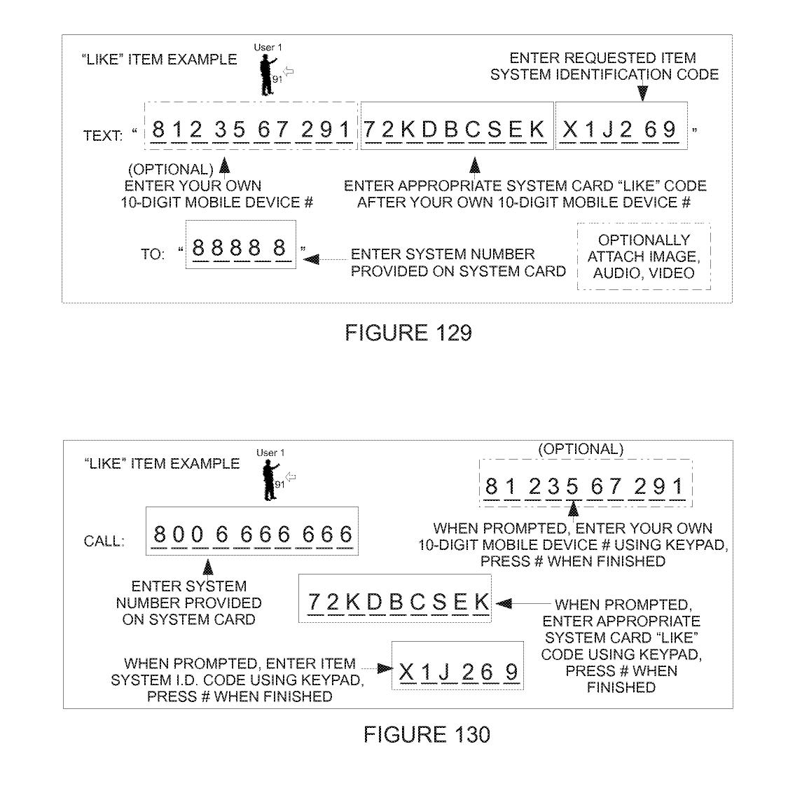

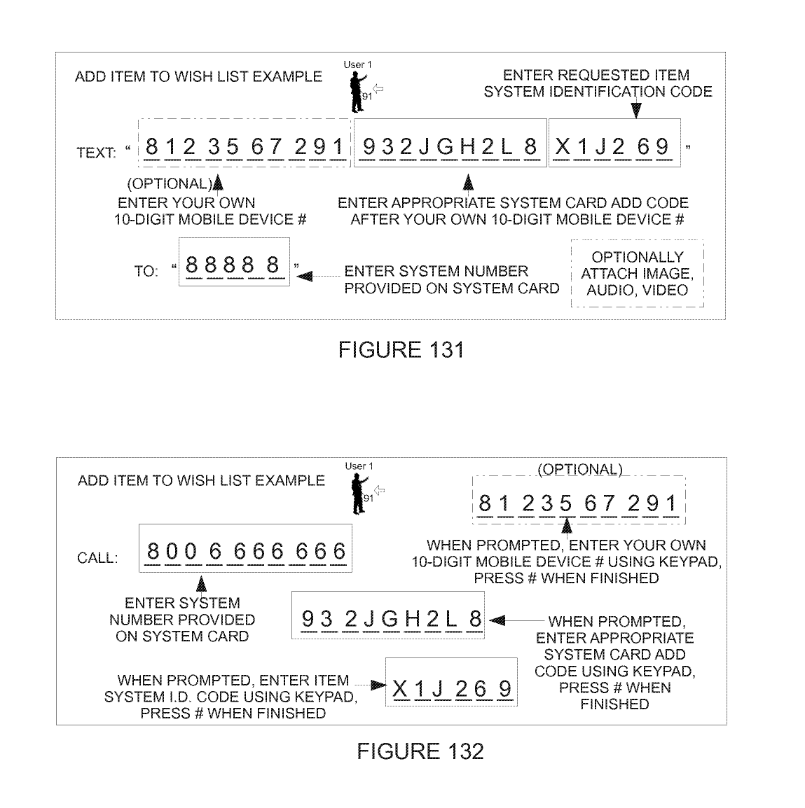

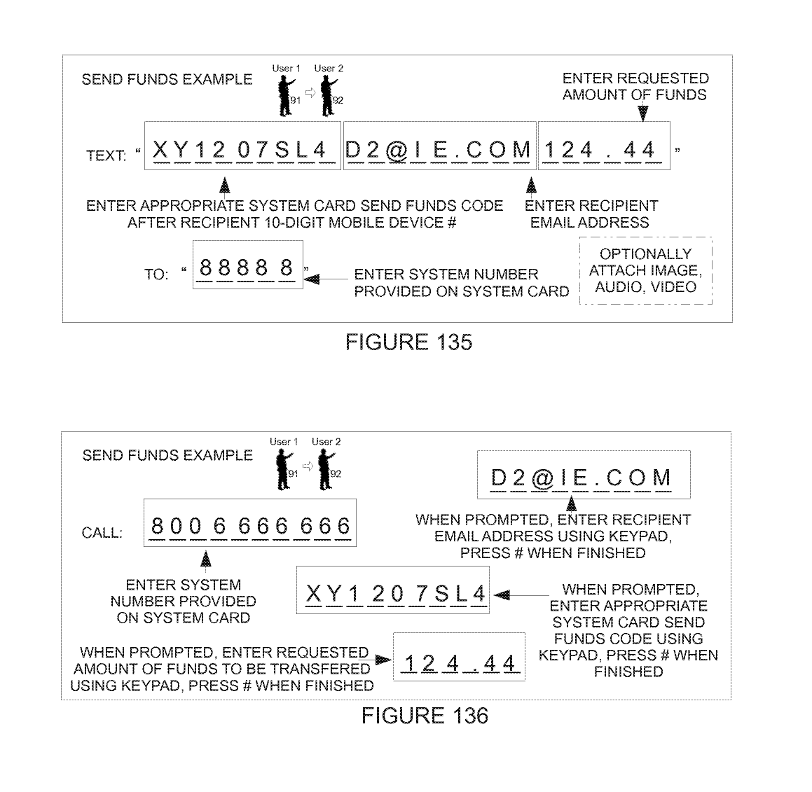

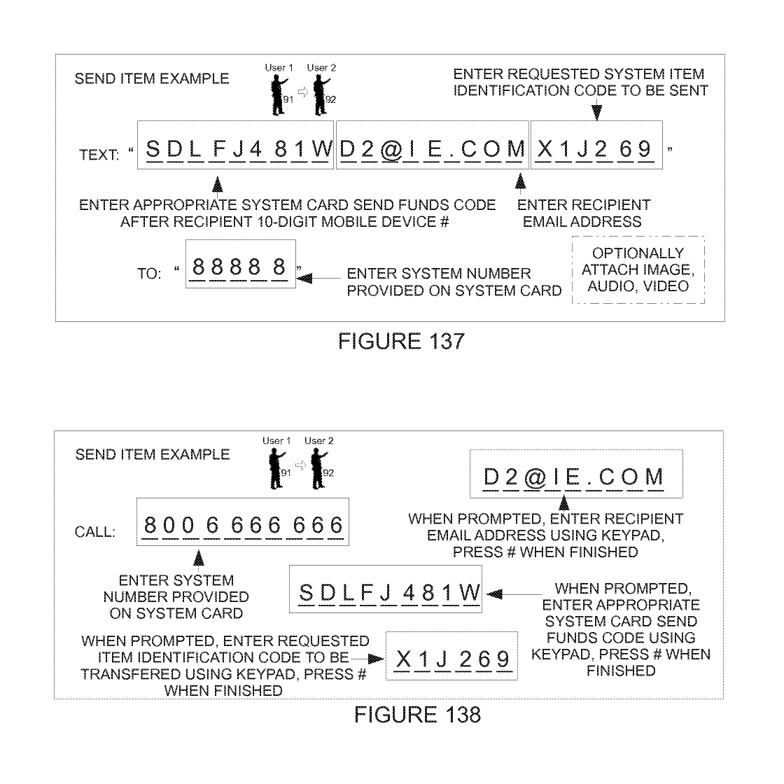

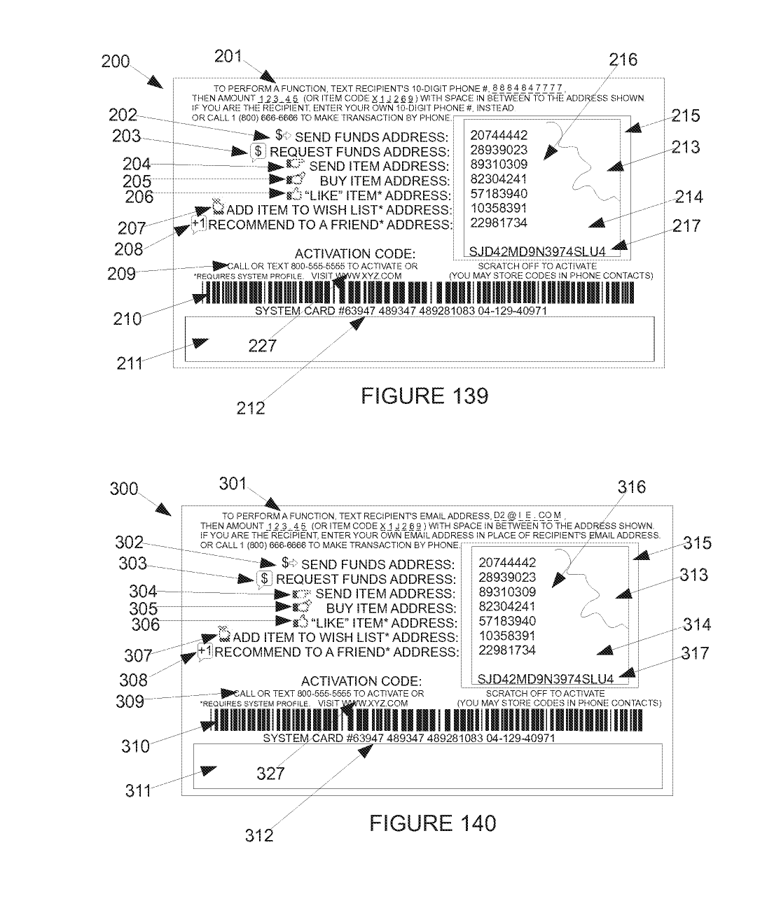

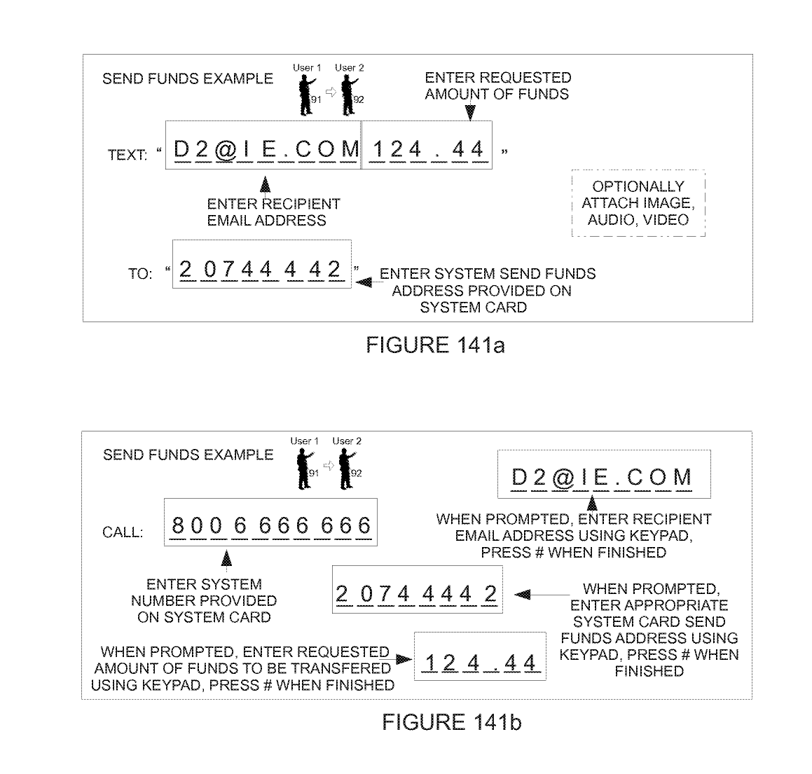

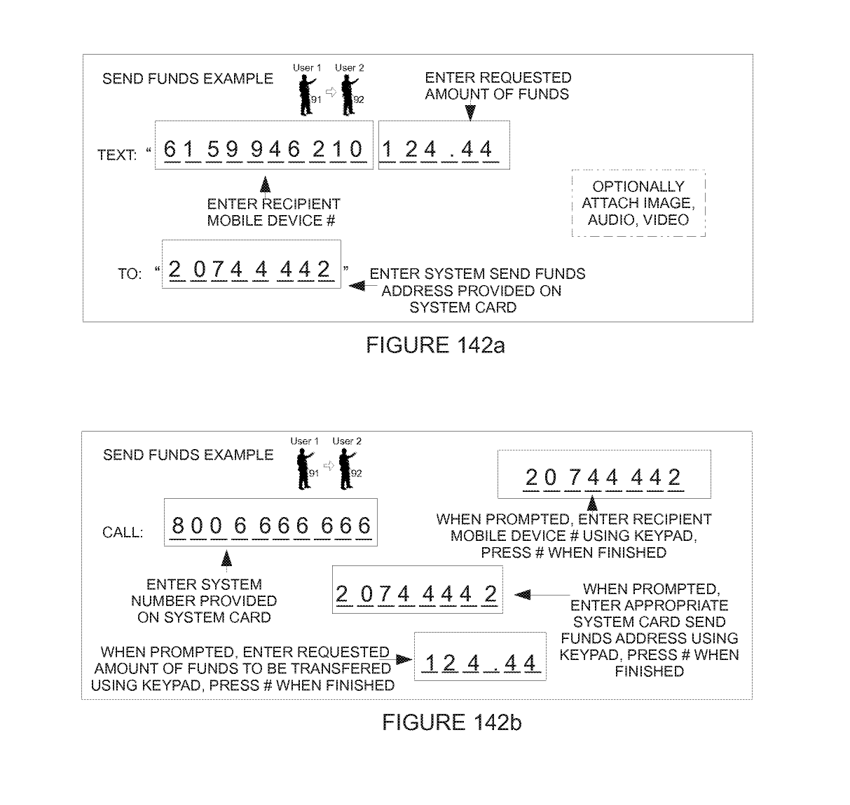

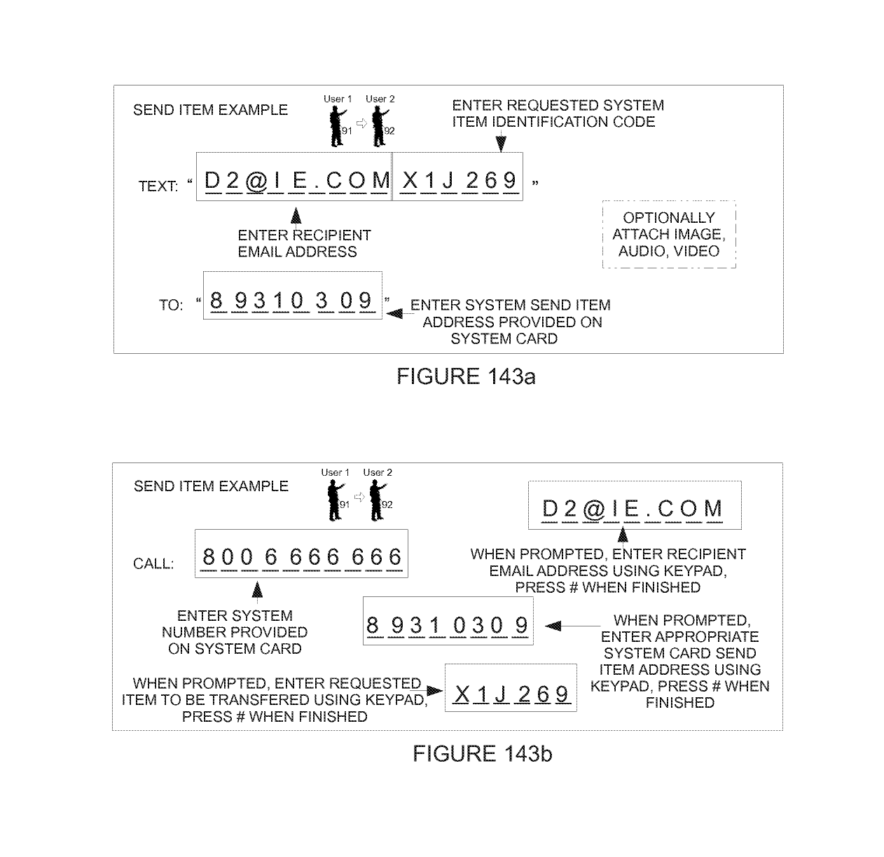

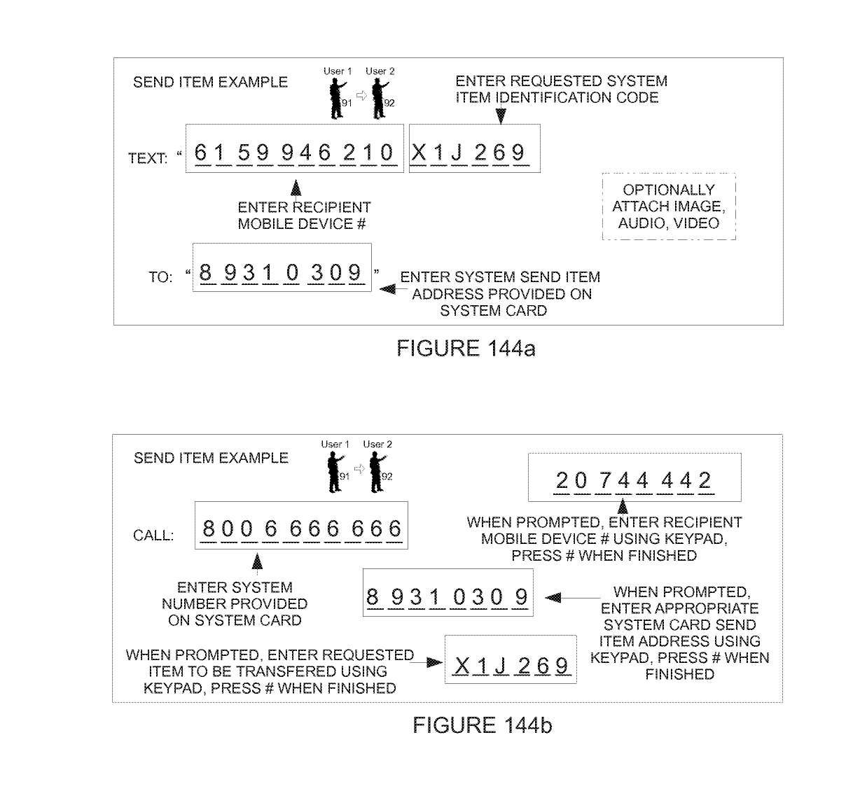

FIGS. 118, and 121-144b, and 164a-1671 show self-explanatory methods of performing certain functions utilizing function codes 116, a mobile device 96, and user data (e.g., recipient email or mobile electronic address information) according to some non-limiting exemplary embodiments. It is anticipated that many variations and/or permutations of the proposed methods exist and may be equally employed.

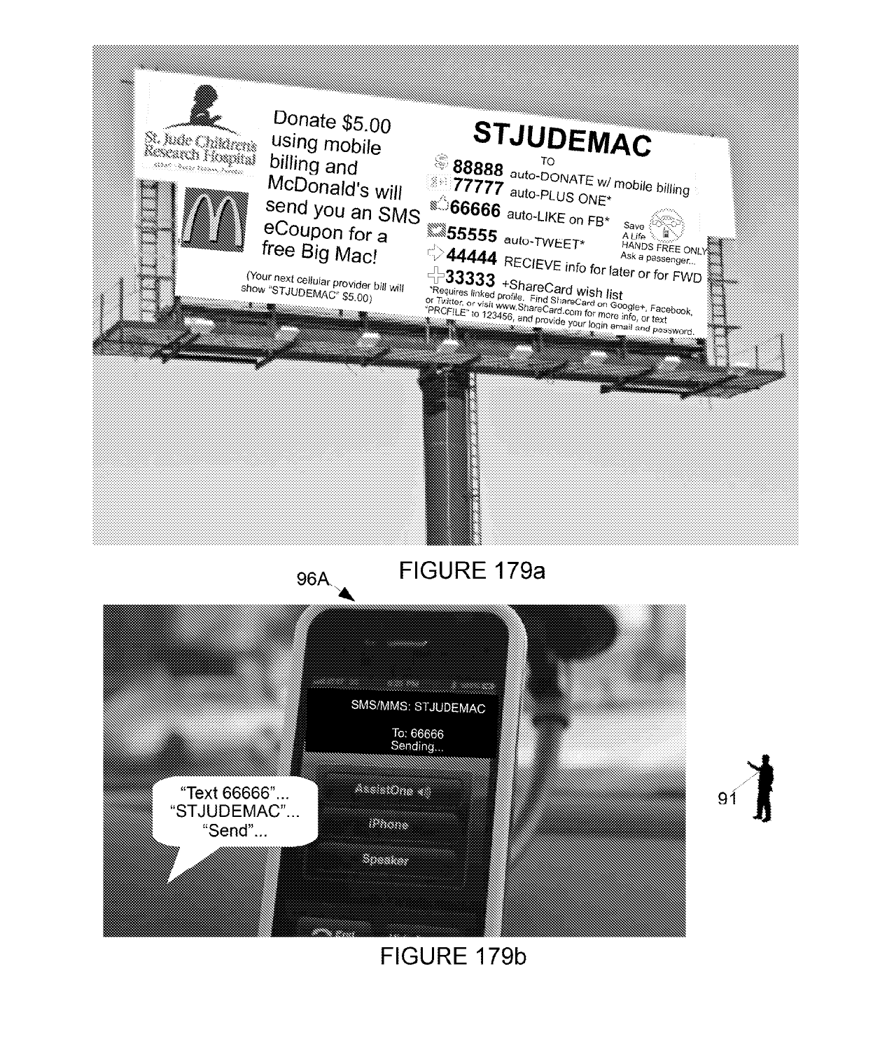

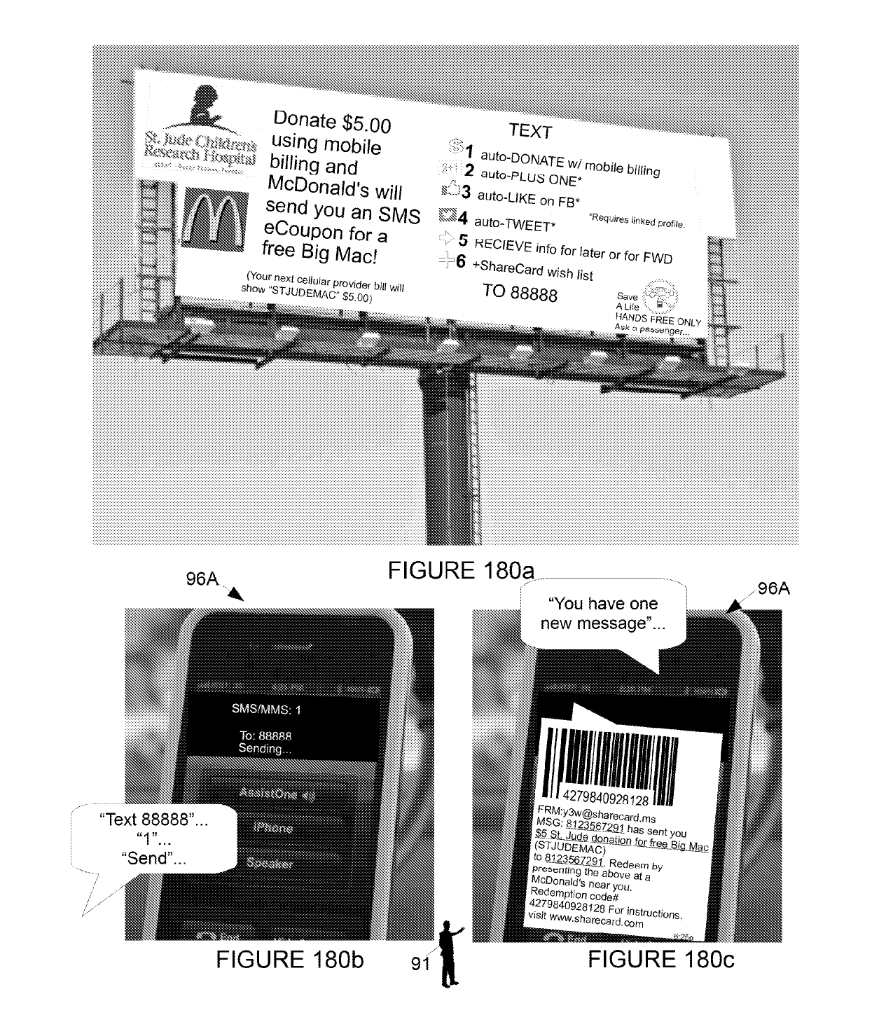

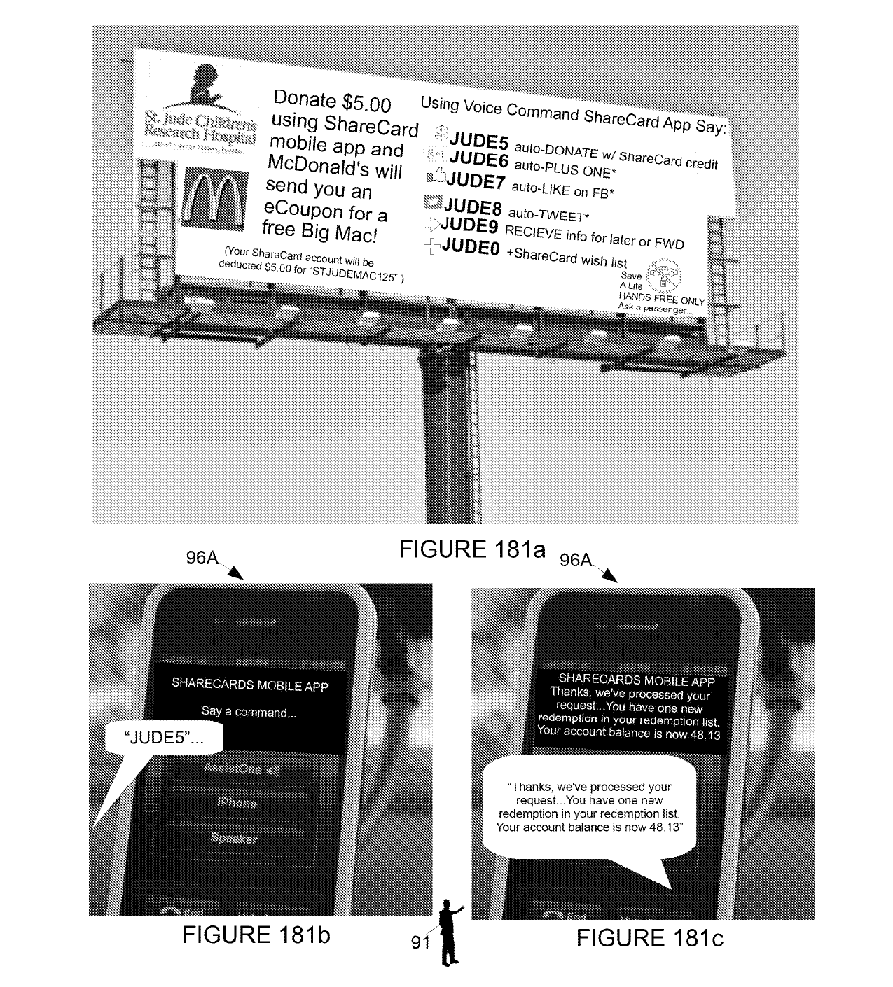

As shown in many of the figures, components of the system(s), method(s), and/or apparatus(es) disclosed may employ advertising means to provide system instructions to users of the system. In some embodiments, such as television or internet-based delivery means, a user may have complete availability and concentration to perform system operations through their mobile device. However, in some circumstances, such as while driving, advertising means such as radio or billboard advertisements may provide such system instructions. To increase safety and reduce the opportunity of users texting while driving, a mobile application provided with voice-command software or otherwise integrated with voice-command software already on a user's mobile device may be employed to facilitate transactions and benefit from the system. Instructions provided by displays (e.g., billboards) may be streamlined for use with the mobile application. For example, simple commands such as “Send Chuck 5543” or “Send 5543 to Chuck” or “Buy item 5543” or “Like 5543” or “Share item 5543” or “Tweet 5543 . . . this is a great deal!” may be employed, without limitation. Furthermore, while the display images shown in FIGS. 179a, 180a, 181a, and 182a might appear too busy for a concentrating driver to read, interpret, and/or utilize, fewer instructions than what is shown may be provided.

In yet other embodiments, displays may provide multiple redemption options, for example, several images of items, products, goods, services, promotions, or offers. Similar instructions may be provided for each of the multiple redemption options. For example, a billboard may comprise four images of different sandwiches and two images of different drink items offered by a participating vendor or selling/entity (e.g., Arby's). Each instruction may comprise information pertaining to how an individual may purchase the respective sandwich or drink item. Alternatively, each instruction may comprise information pertaining to how an individual may send the respective sandwich or drink item to a contact, relative, or friend. Even more alternatively, each instruction may comprise information pertaining to how an individual may perform a social function such as “like”, “share”, “post”, or “tweet” about the respective sandwich or drink item. Even more alternatively, each instruction may comprise information pertaining to how an individual may recommend the respective sandwich or drink item. Even more alternatively, each instruction may comprise information pertaining to how an individual may add the respective sandwich or drink item to their wish list or a note list for later review and/or access. The instructions may differ between the sandwiches and drink items. For example, each sandwich and drink item may comprise a different item number or different instruction. In another instance, a first instruction for a first sandwich may suggest an instruction such as “Say “ONE” using the ShareCard mobile app” (to purchase, send, provide a favorable opinion via a social network, recommend, or add the first sandwich to the user's wish list), and a second instruction for a second sandwich may suggest an instruction such as “Say “TWO” using the ShareCard mobile app” (to purchase, send, provide a favorable opinion via a social network, recommend, or add the first sandwich to the user's wish list). In yet another instance, In another instance, a first instruction for a first sandwich may suggest an instruction such as “Voice text “ONE” to “24000” using the ShareCard mobile app” (to purchase, send, provide a favorable opinion via a social network, recommend, or add the first sandwich to the user's wish list), and a second instruction for a second sandwich may suggest an instruction such as

“Voice text “TWO” to “24000” using the ShareCard mobile app” (to purchase, send, provide a favorable opinion via a social network, recommend, or add the first sandwich to the user's wish list). The short codes may be different for different billboards containing different redemption options or billboards affiliated with different vendors/selling entities.

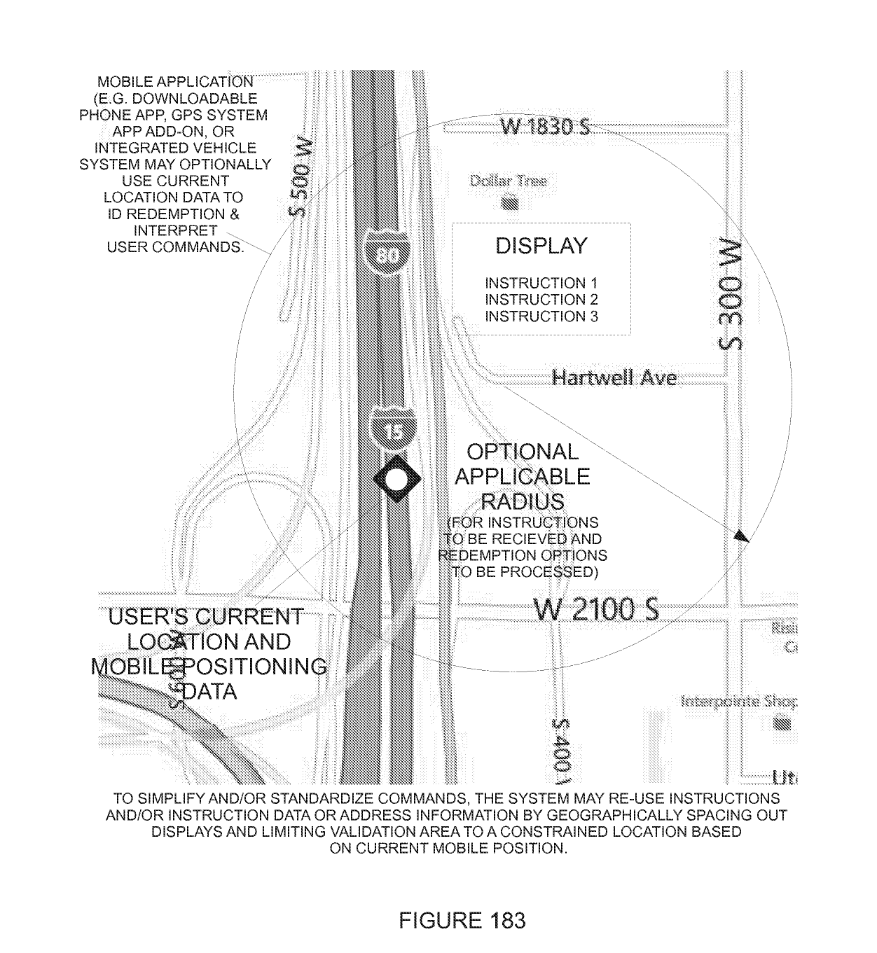

In yet other embodiments, displays may state “To like this, text xyz to 123,” or “To like us, text LIKE to 65040” or “Save this to your wish list by saying “Wish” now using your voice-command enabled ShareCard app”, or “Dial 888-ShareCard within the next two miles to like this”, or “Voice dial 800 ShareCard now to buy or send to a friend”, or “Say a contact's name and then the item number provided to electronically send the item to your friend”. In some cases, the user's current mobile position data may be known by the system application while it is running (for example, if the user's mobile device location data preference is turned on or otherwise set to “active”). Referring to FIG. 183, so long as the call is made within the indicated range provided on the display, the system application may automatically determine which redemption option(s) are being sought by the user, thereby simplifying the commands necessary to complete a system transaction. In some embodiments, the call may not necessarily need to be completed, wherein a user may call a system electronic address, and hang up; wherein the system may be configured to determine a function to perform, and/or an output to be made. The system may predetermine placement of such displays and instructions and stagger them so as to avoid potential overlap. For example, the system may work with advertising billboard agencies (e.g., outdoor media advertising agencies such as Yesco, CBS, or Reagan Outdoor Advertising) strategically place and stagger displays containing instructions which are compatible with and/or recognizable by the system. The system may receive user commands by the user calling or texting a system number, or, the system application may process the user commands using a web-based platform or wireless application protocol (WAP) supported by a wireless network (e.g., CDPD, CDMA, GSM, PDC, PHS, TDMA, FLEX, ReFLEX, iDEN, TETRA, DECT, DataTAC, or Mobitex) and a mobile device operating system (e.g., PalmOS, EPOC, Windows CE, FLEXOS, OS/9, JavaOS, iOS). The system application may support HTML, XML, and contain WML language or script. In some embodiments, the system application may preferably comprise a browser, frames, tables, cookies, CSS, VB script, JavaScript, Java applets, ActiveX controls, CallBack, and XMLHttp. In some embodiments, the system application may preferably support GPS and location-based services, order-tracking, item purchases, and functions typically utilized by banking services, without limitation.

In short, it is anticipated that simpler commands may be utilized with a system-integrated mobile application for driving uses (e.g., radio and/or billboards), and that the more involved SMS instructions disclosed herein may be utilized with advertising means (e.g., TV, store displays, etc.) targeting users which may not be as distracted.

Alternatively, or in combination with the above-suggested methods, the user may add a system number or short code to their phone or vehicle-integrated voice command/voice-activated dialing system (e.g., SIRI) to integrate system capabilities which are safer for use on the road. In some embodiments, a user may voice dial a system-provided number to access an automated “bot” operator which has voice-command/voice recognition and interpretation software (e.g., an automatic speech recognition (ASR) software-enabled number, an automated care operation platform, speech-enabled software customer service number, an automated contact center, voice-enabled customer service hotline service, customer service automation solutions, voice software solutions, an automated outbound/inbound dialer, an interactive voice response (IVR) software-supported solutions, automated response services, speech services telephone automation, cloud inbound call automation, contact center automated attendant software, voice-based marketing automation (VBMA), voice-enabled applications, speech-enabled virtual operator/customer service software, DTMF tone input-based software-enabled platform, automated attendant(s) (AAs), interactive messaging response (IMR) software/protocols, caller line identification (CLI) data-receiving, validating, and processing software, biometrics software (e.g., voice print), dialed number identification service (DNIS)-utilizing software, automatic number identification service, caller ID services, call display/record software, speech-recognition software, automatic call distributors (ACDs), session initiation protocol (SIP) point-to-point communications service software, etc.). The automated software may allow a user to navigate menus and options verbally, without having to take their eyes and hands off the road. In some embodiments, system card information (such as the function codes 116 described herein (e.g., 102-108) may not entirely be necessary using a system-integrated mobile application. In such embodiments, so long as the phone associated with the user account is placing the call or text to the system's SMS/MMS gateway(s), the system may accept, validate, and perform system functions, operations, executions, and method steps without necessarily requiring information provided in the card.

In some embodiments, a mobile application affiliated with the system may allow a user to redeem credits or pre-paid redemption options associated with a particular vendor/selling entity by snapping a photo of, or otherwise capturing a QR code or other image provided at the vendor/selling entity's P-O-S checkout area, such as one provided adjacent the vendor/selling entity's EFT payment terminal. When the image is captured, the mobile application recognizes the vendor/selling entity, accesses the funds, credits, or pre-paid redemption options associated with the vendor/selling entity that may be possessed by the user, and displays the funds, credits, or pre-paid redemption options on the user's mobile device for the user to select from so that the user may redeem one or more of the selected funds, credits, or pre-paid redemption options. The mobile app may be configured to instantly deliver one or more additional offers, promotions, or discounts upon capturing the vendor/selling-entity-provided image.

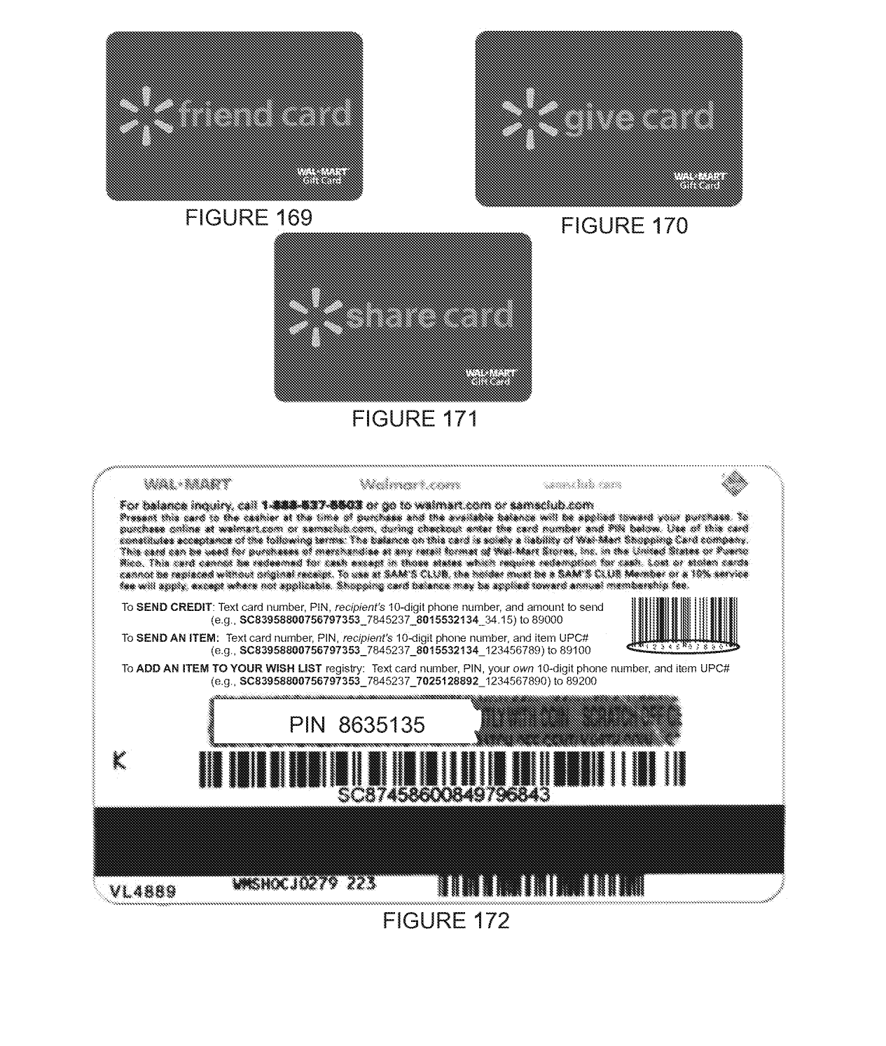

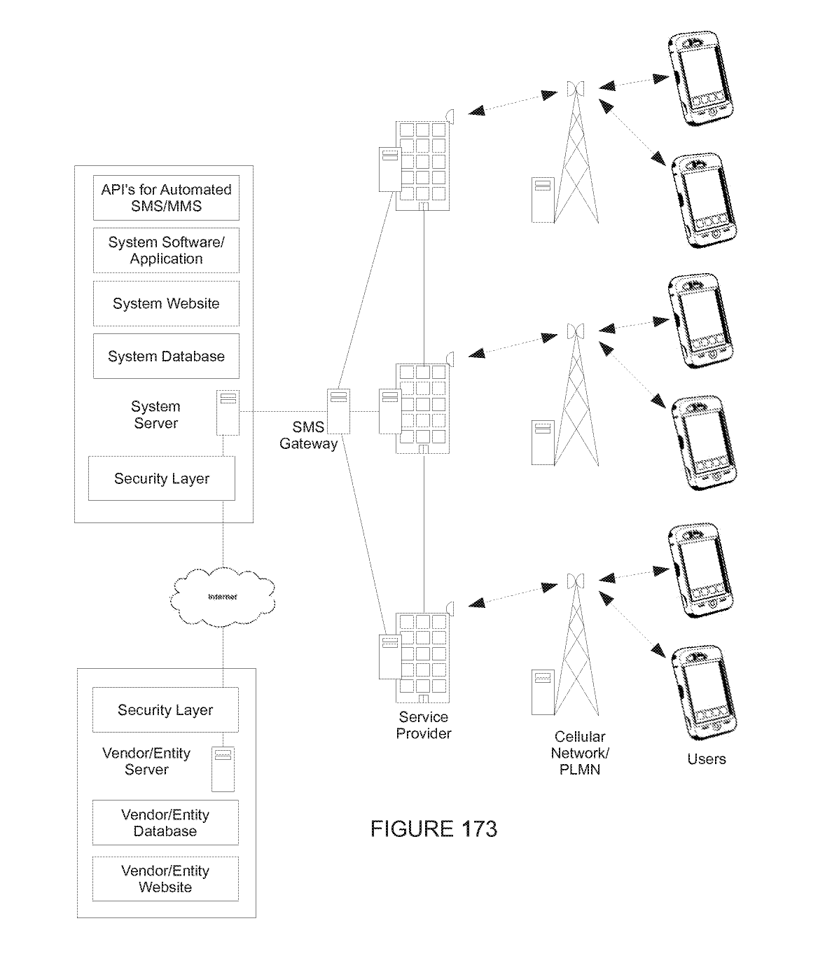

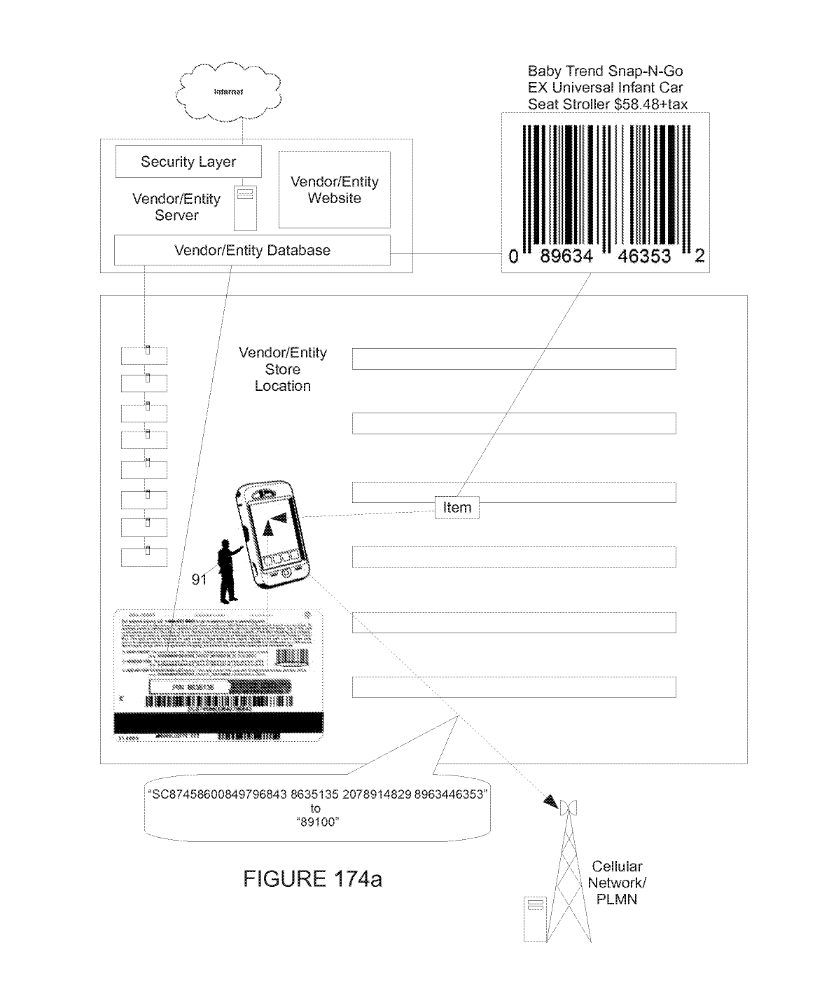

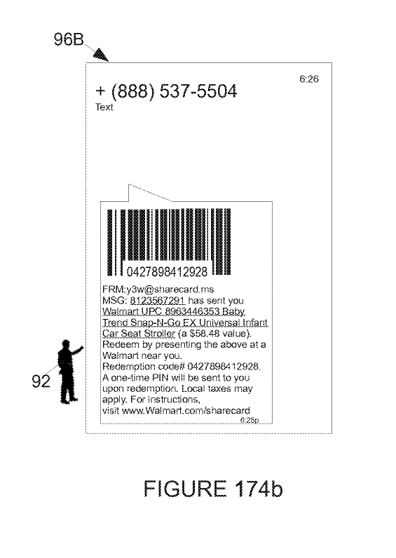

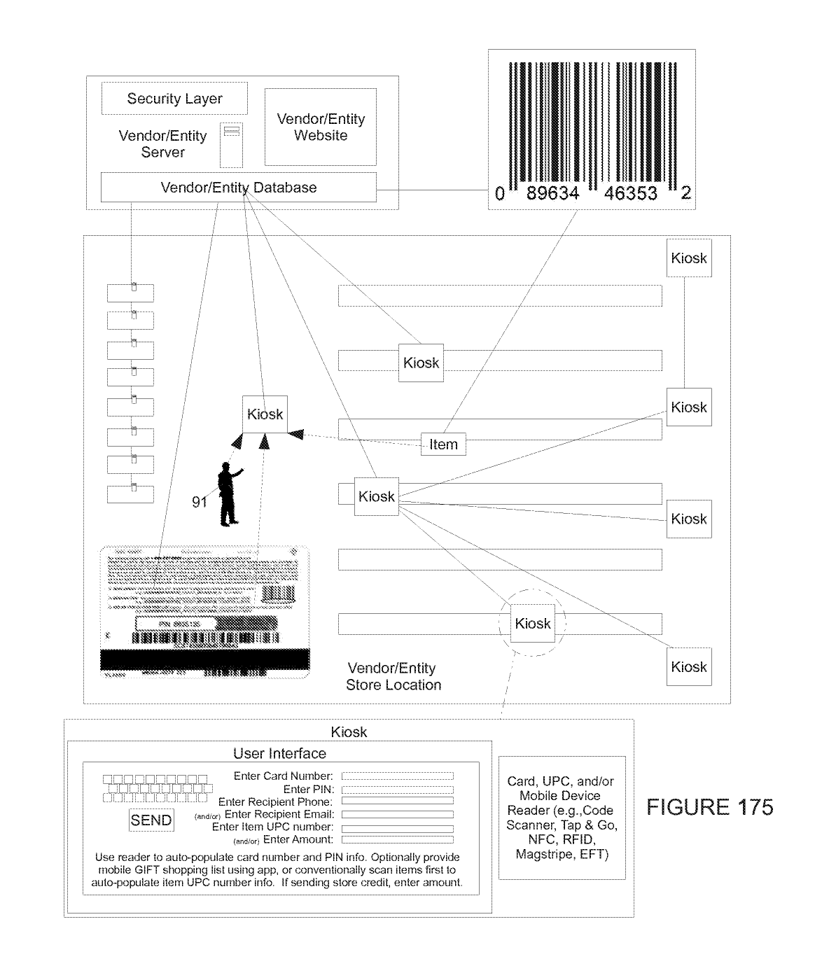

Turning now to FIGS. 174a and 174b, a user of the system may purchase and send items to another individual using SMS/MMS protocol while shopping at a brick-and-mortar facility. In some embodiments, this may be done using a universal card 100, such as a bank or major credit card-issued pre-paid debit or credit card. However, the same may be performed using a store-specific card. For example, a non-universal store-issued card (e.g., the Walmart-issued system card as shown in FIGS. 169-172) may be utilized while shopping in a Walmart store. A user 91 may purchase the card and add system credit to the card by paying cash, credit, debit, or store credit. The user 91 may activate the card on the spot by calling or texting the indicated number. The user 91 may then “window shop” for a gift for another individual 92. When a desired item is found, the user 91 may follow instructions on the card to send the desired item to the other individual 92. If the other individual 92 has a similar Walmart-issued store-specific card, a simple credit transfer may performed. Alternatively, whether or not the other individual 92 is a cardholder, the user 91 may “send item” by utilizing the store SKU number, UPC number, or special Walmart-provided system item code provided adjacent the shelving adjacent the item. Alternatively, a special Walmart-provided system item code may be provided to tags of items. In this regard, a user 91 may be able to shop for an item in person (rather than online) to inspect a product and make a better purchasing decision, with the ability to gift like an online purchase. In the particular embodiment shown, the user 91 may text the card number, send item code, recipient mobile device number, and item number to the number provided on the card, or otherwise calls the number provided on the card and may provide the information via an auto attendant system. While it may be shown that the user 91 is requested to provide the card account number 112, other embodiments may not necessarily require it, and may, for instance, require a command such as “senditem”, or a number conveying a send item instruction, e.g., “2” for send item, or a card PIN. So long as information is conveyed to the system indicating a user's desire to send an item (or perform another function described herein), it is anticipated by the inventor. Once the transaction is made, the user's 91 account may be debited, and the recipient 92 may be sent an electronically-delivered pre-paid voucher for the item redeemable at a participating franchise location (e.g., another Walmart). As shown in FIG. 174b, the recipient may redeem the prepaid item by scanning the delivered pre-paid redemption data to a store employee or entering the data on the vendor's online marketplace (e.g., Walmart website) for online redemption. FIG. 175 suggests another method according to certain embodiments, which employs the use of mini-kiosks or terminals which may be distributed throughout a brick-and-mortar facility to facilitate similar transactions. Cardholders affiliated with the system which may not have access to a mobile device may interact with the kiosks to perform similar transfers of funds, credits, social media functions, and/or sending/receiving items, funds, or credits. Some or all of the mini-kiosks may be provided with a reader, such as one or more of a card reader, a UPC scanner, a cell phone display reader, or NFC-configured configured device reader to facilitate customer transactions and improve customer shopping experiences. Cardholders may access balances, check prices of items, and send/or receive items by interacting with the kiosks. In some embodiments, rather than delivering store-accepted funds, credits, or prepaid redemption options via SMS/MMS, a card user may tap, swipe, or scan their card at a kiosk the next time they are in the store. A user may utilize a mini-kiosk to add a physical item to their wish list, digital shopping list, or gift list.

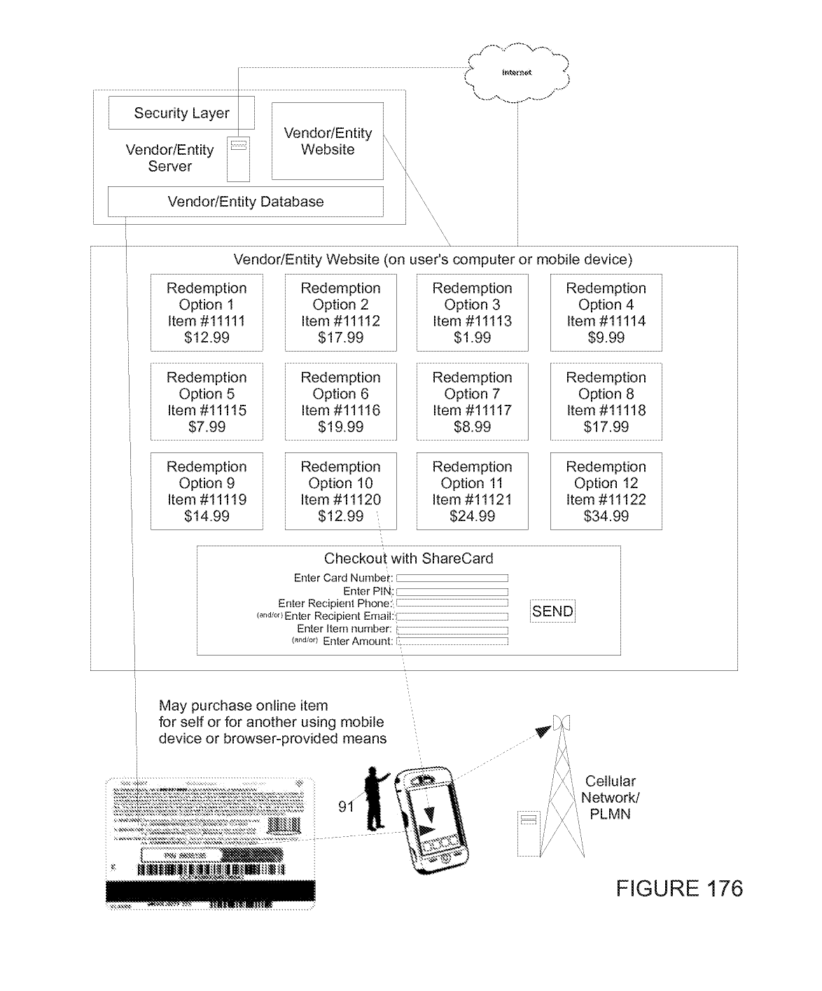

FIG. 176 suggests a method within the scope of certain embodiments. A user may utilize a system card while shopping online. In this regard, a user 91 need not provide information via a web form or URL secure checkout page. According to some embodiments, a user need not create an account with the vendor/selling entity for a one-time purchase. The entity's website may provide item numbers with redemption options, along with the price. The user 91 may utilize the item number to pay by phone in one of the many ways described herein, and/or send the item to another user. The next time the user 91 is in the store, the user may grab the preordered item, and display the pre-paid voucher to the merchant's employee at a P-O-S checkout payment terminal. Applicable state or local taxes or fees (or shipping fees if ordering online) may be calculated in advance (e.g., using a website “calculate/estimate tax in your provided area code” prompt and user-fillable field, or an “calculate/estimate shipping costs” prompt and user-fillable field). Alternatively, the next time the recipient 92 is in an affiliated store, or online at an affiliated store website, the recipient 92 may redeem the item, (or otherwise, checkout online using the redemption data, enter their shipping address, phone, contact info, etc). Of course, a more traditional checkout page field may be provided for a user 91 to enter card credentials and recipient user data.

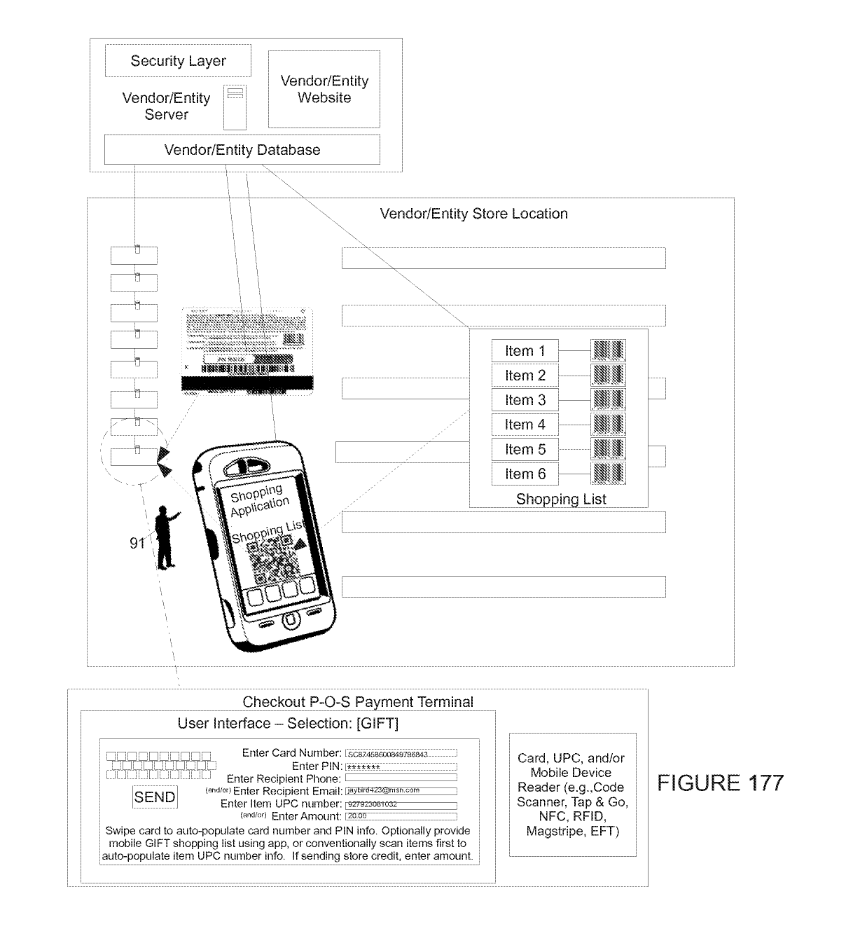

FIG. 177 suggests a method of gifting a digital shopping list at a P-O-S checkout. For example, a user may scan UPC codes of items to be gifted using a mobile application, and then using the entity-provided P-O-S checkout payment terminal, gift the digital shopping list by selecting a “gift” option. A system card may be used to complete the transaction. Delivery to the recipient may be electronic, such as via SMS/MMS, voicemail, or email. The delivery may include a barcode, such as a QR code representing the pre-purchased shopping list.

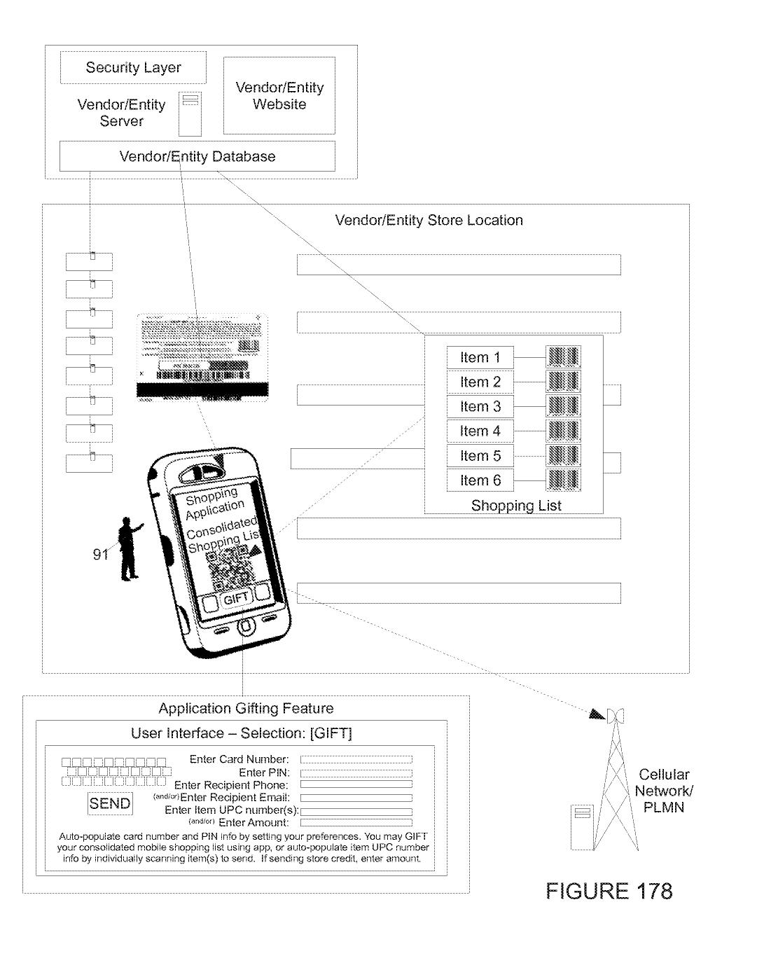

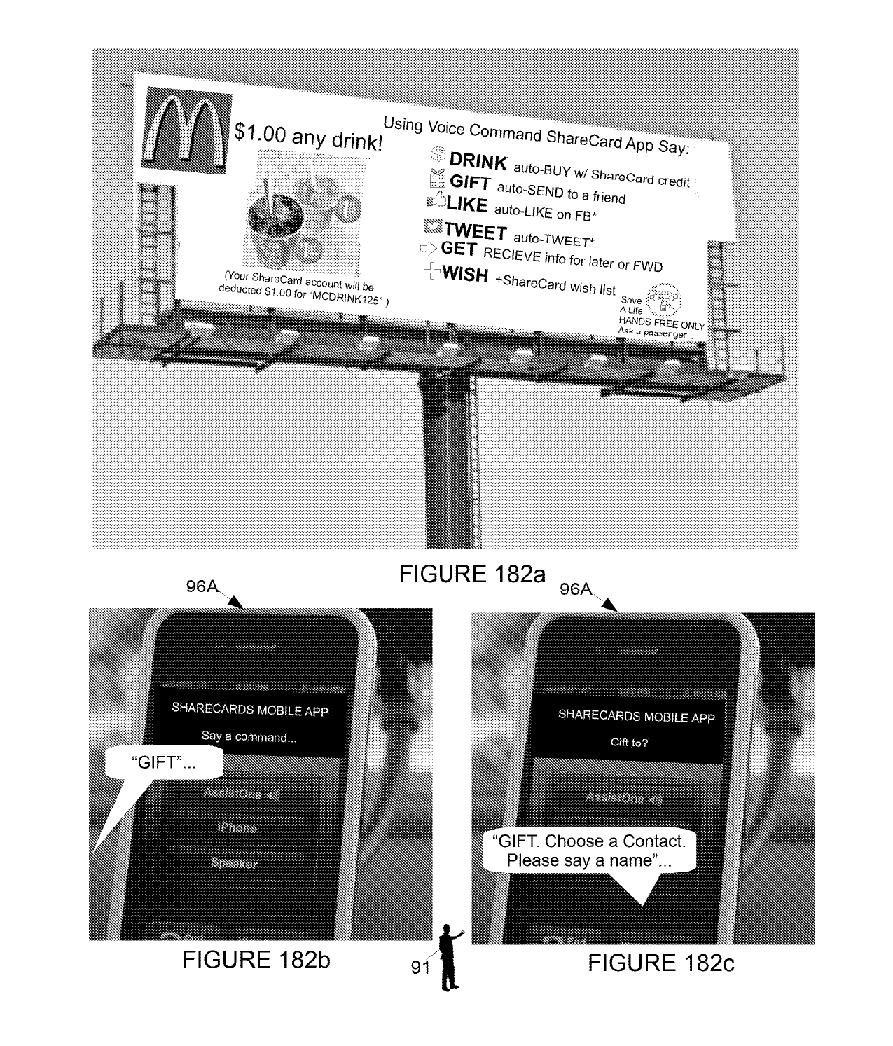

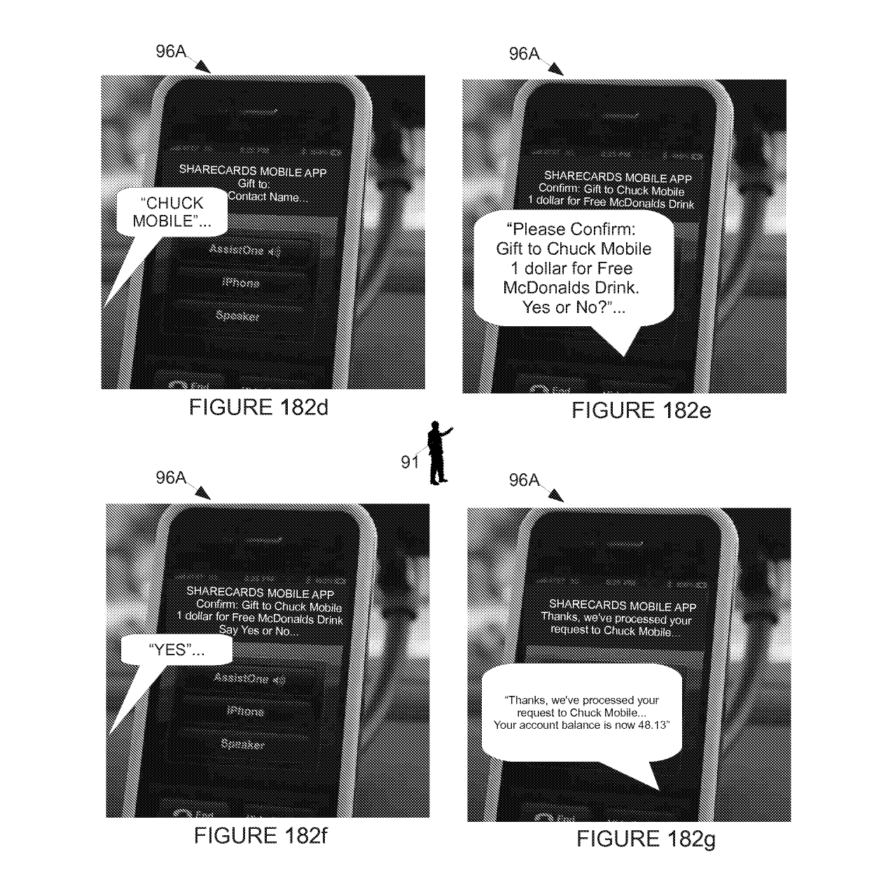

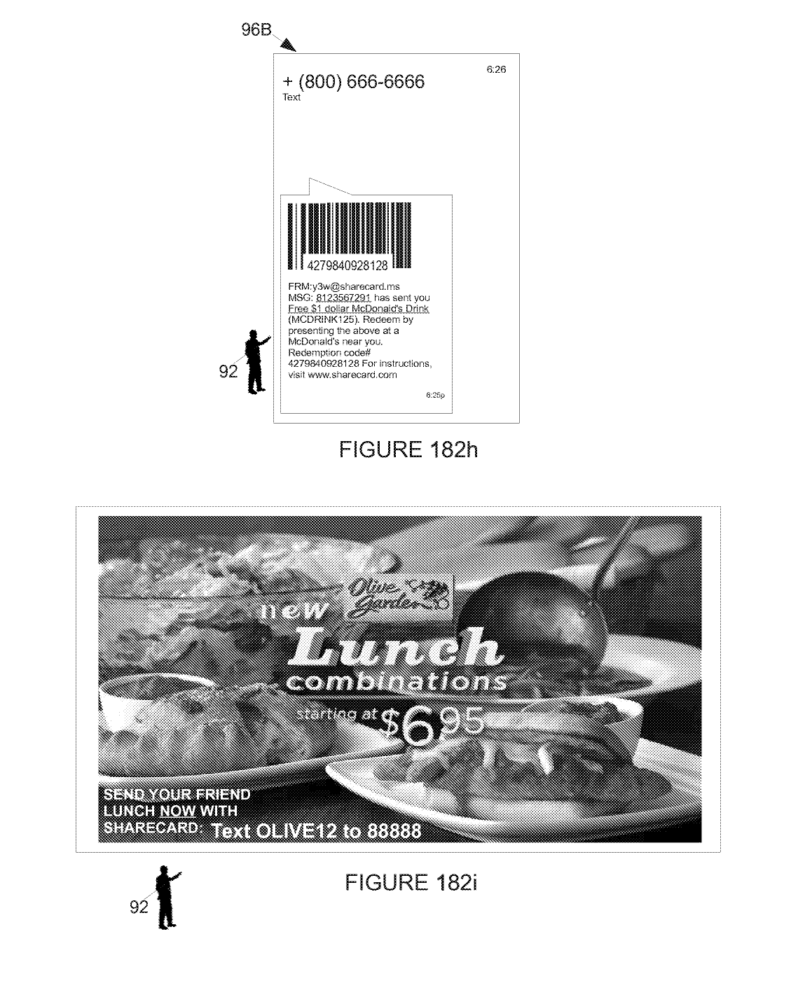

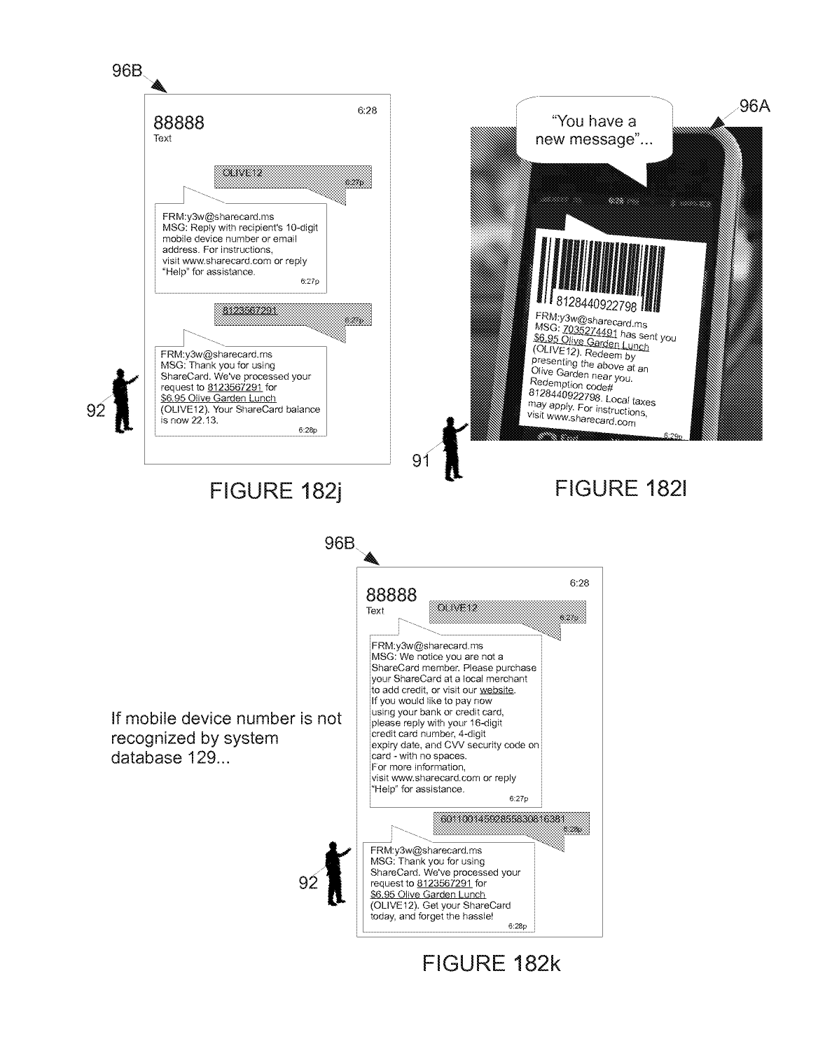

FIG. 178 suggests a method similar to FIG. 177; however, payment and checkout may be done from the user's 91 mobile device 96a, without needing to engage a P-O-S checkout payment terminal. The user may use the gifting feature on the app's user interface to utilize card funds or credits to send the pre-paid shopping list to another individual. FIGS. 179a-181c suggest various ways that a voice-enabled mobile app or vehicle-integrated voice-activated command/dialing/texting system may be utilized to make purchases, send items, make donations, update social profiles, send credits, receive credits, etc. FIGS. 182a-182h suggest one possible interaction of a first user 91 sending another user 92 a pre-paid redemption option on the go. The recipient user 92 happens to be watching television and wishes to thank the first user 91 for the token gift. The recipient user 92 sees a television commercial advertisement with an instruction on how to send lunch to a friend (FIG. 182i). The recipient user 92 follows the instructions to send the first user 91 (FIG. 182j), and sends the first user 91 a free lunch (FIG. 182l). If the recipient 92 happens to not be a system user (FIG. 182k), he/she may still complete the transaction via mobile billing or by providing credit or bank card information. Alternatively, the recipient 92 may visit to the system website to purchase a “virtual card” which may be stored electronically on the second user's 92 mobile device 96b, or printed out and stored in the second user's 92 wallet for future system transactions and/or updating their social network profiles on the go in a level of detail and convenience not currently enjoyed to date. In any event, the recipient 92 is enticed by the first user 91 to purchase a system card, or otherwise become involved in the system to share with others.

FIG. 183 suggests one way that the system may standardize commands, addresses, and redemptions, thereby eliminating the need to enter an item code and simplifying the process for mobile (e.g., “driving”) use. A mobile application (e.g., a phone application or vehicle-friendly voice command system such as SIRI Apple iOS7 Sirius XM platform) with location data enabled determines the user's current location. A system-integrated first display containing instructions is employed within a zone of proximity to the user's current location. So long as the user is within the zone of proximity, the instructions may be validated, accepted, and a transaction completed. Once the user exits the zone of proximity, the instructions are no longer valid. Another second system-integrated display having instructions pertaining to a redemption option, offer, promotion, etc., may be provided a predetermined distance away from the aforementioned first display. Any instructions sent by the user may apply to the redemption option, offer, promotion, etc. displayed on the second system-integrated display. A system user may make purchases, transfers, and gift while commuting. The system-integrated displays may be road signs, vendor/selling entity signs visible from a road or highway, inflatable blimps or balloons, etc., without limitation.

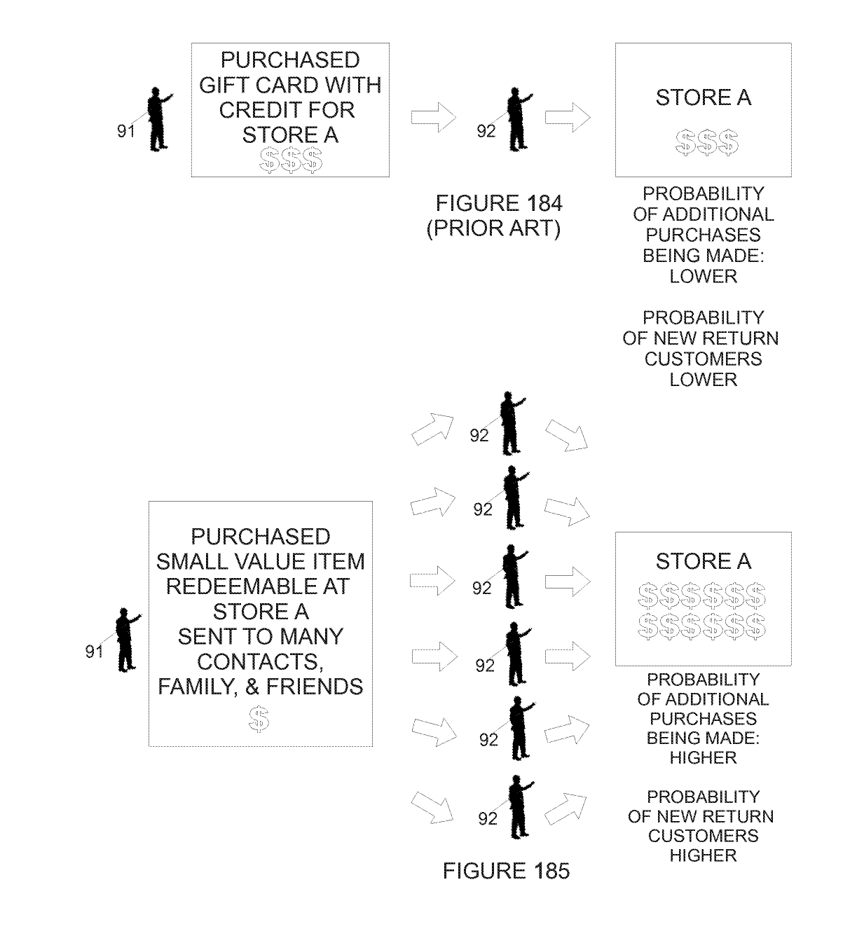

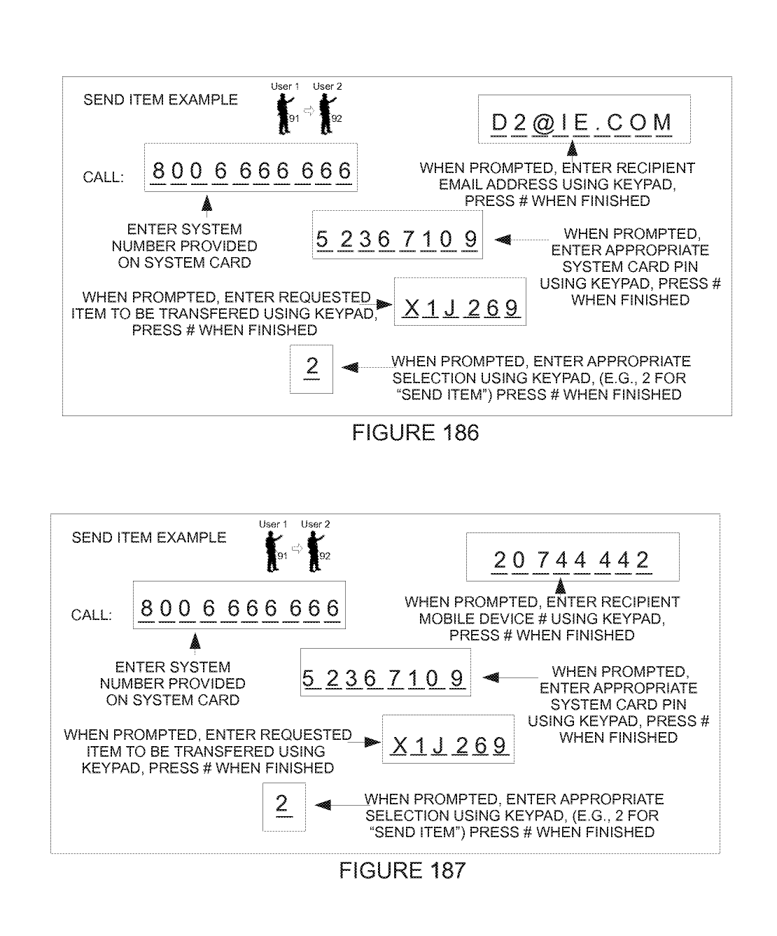

FIGS. 184 and 185 visually demonstrate some non-limiting advantages that accompany small incremental gifting purchases which may be facilitated using system components and method steps according to some embodiments. Notably, the number of recipients may be greater and/or more diverse, and may drive new sales by getting the larger number of recipients to the vendor's store or web-based marketplace.

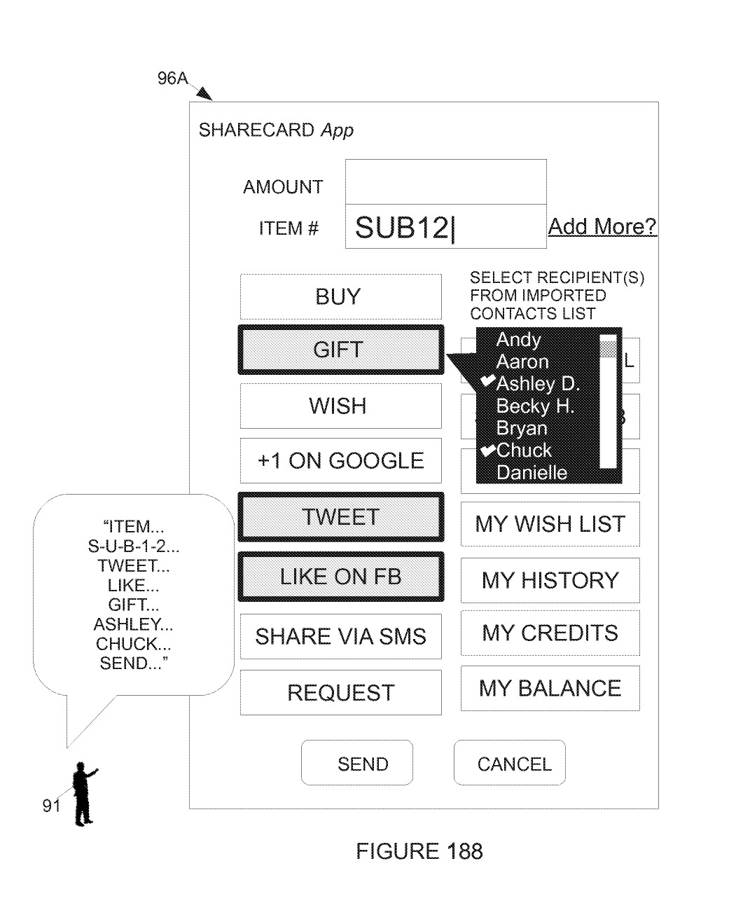

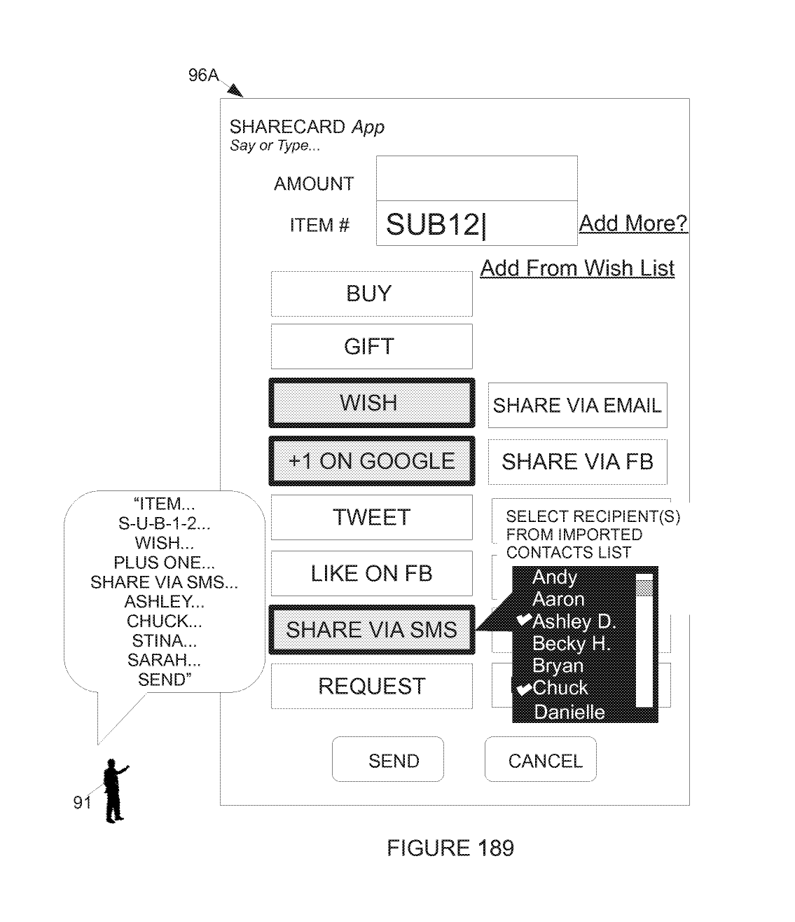

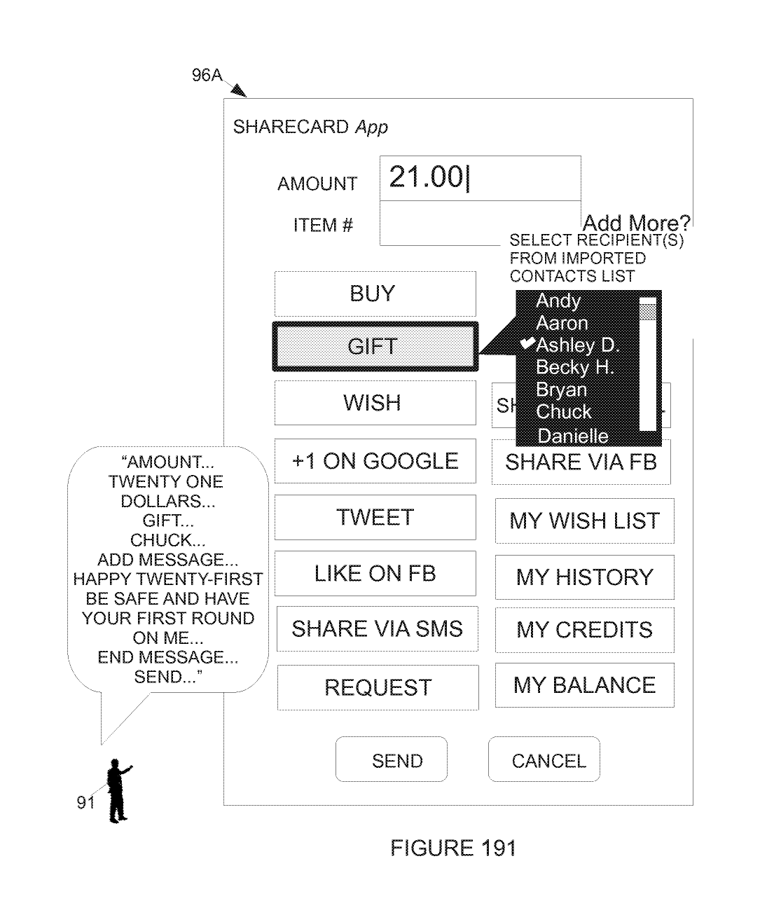

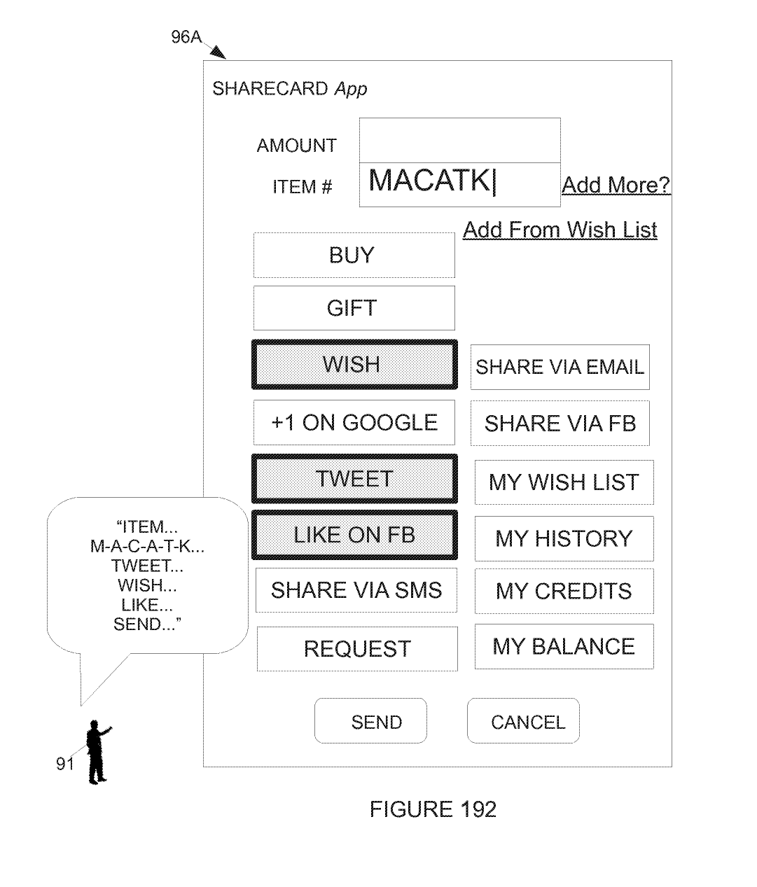

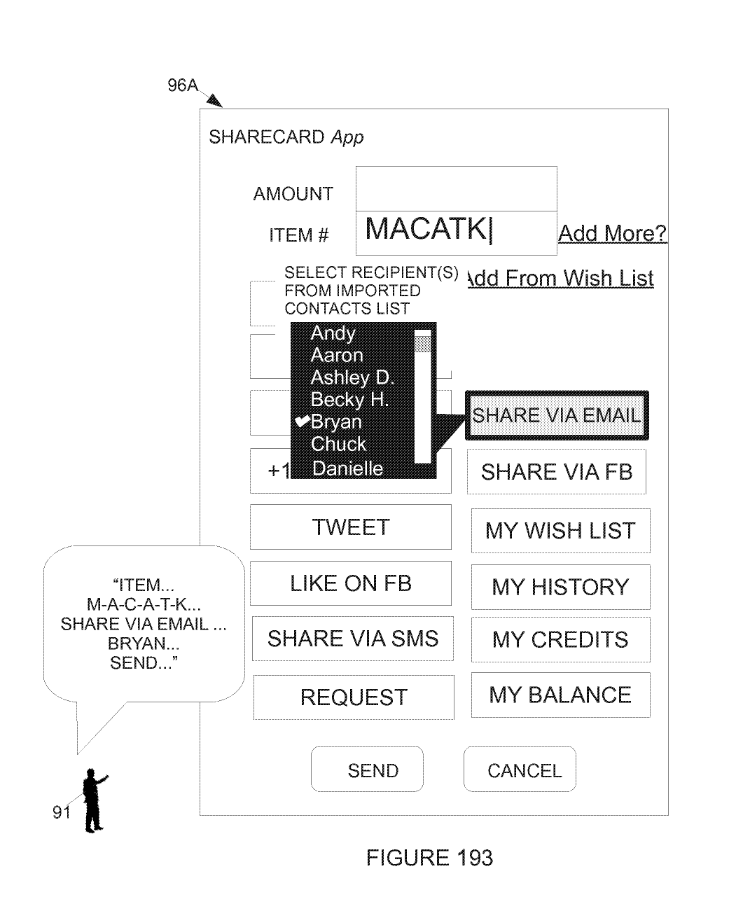

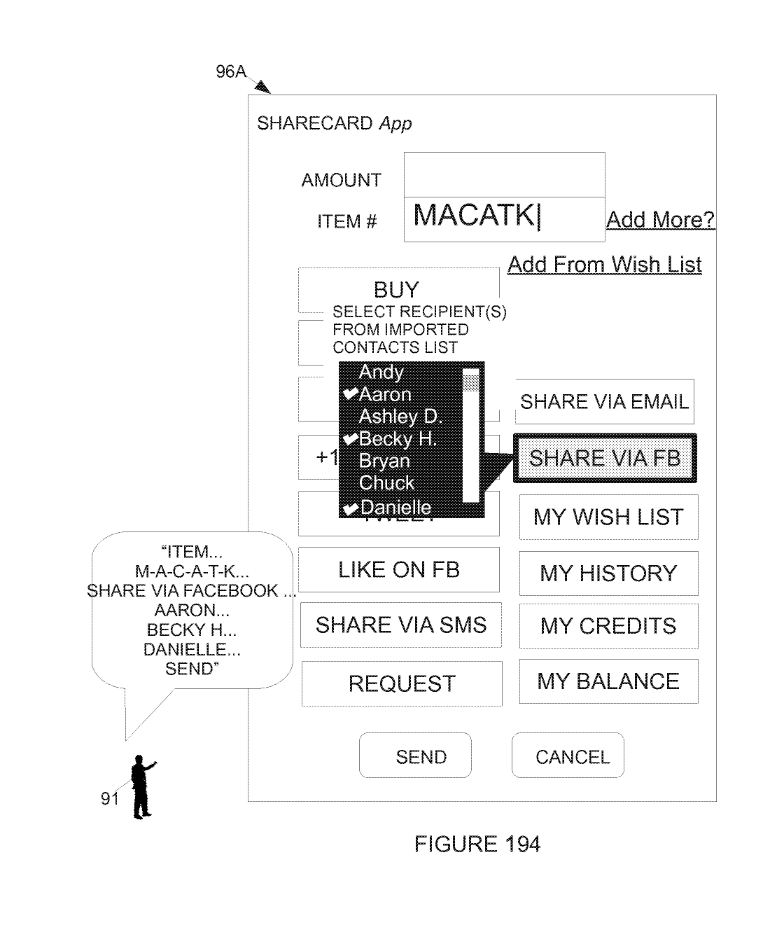

FIGS. 188-190a, and 191-194 suggest some possible manners in which a system mobile application may be utilized to streamline or otherwise facilitate transactions described herein. For users possessing a mobile device 96, a downloadable app 147 comprising a simple user interface 106 may be provided. The app may allow transactions to be performed in high volumes without necessarily incurring additional charges for excessive text messaging. One or more functions, operations, features, advantages, method steps, icons, buttons, software, information, and/or data or used by the mobile application 147 may be incorporated or otherwise integrated with other third-party applications which may already be in existence. For example, the mobile application may be packaged as an add-on module or third party system application update or new release version, without limitation.

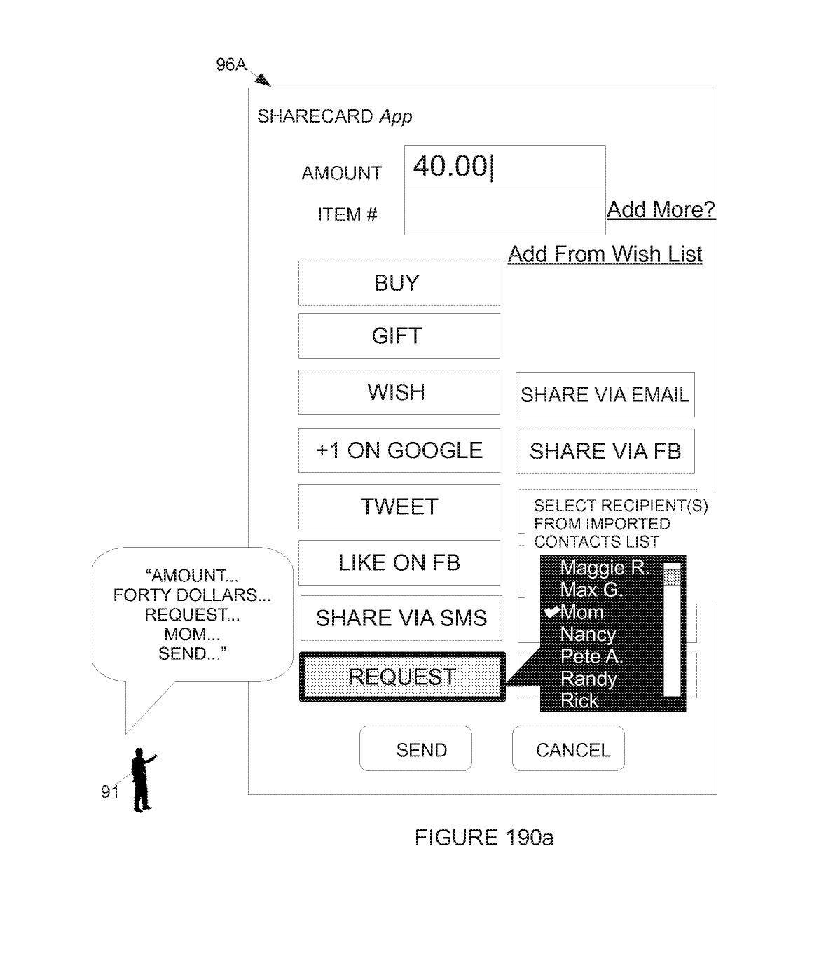

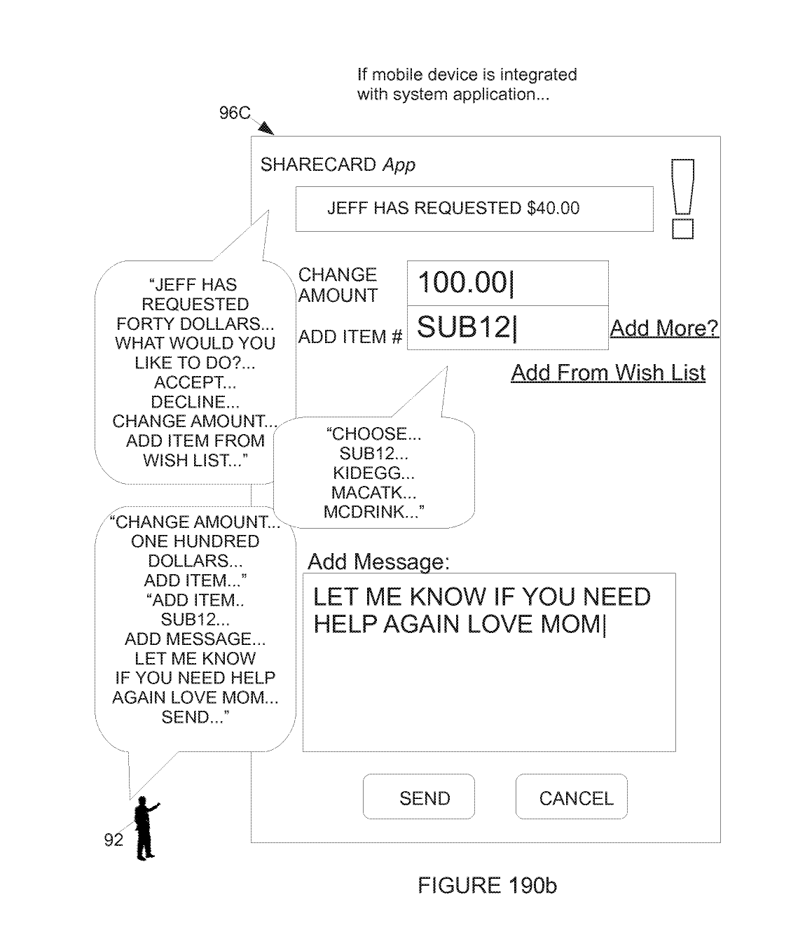

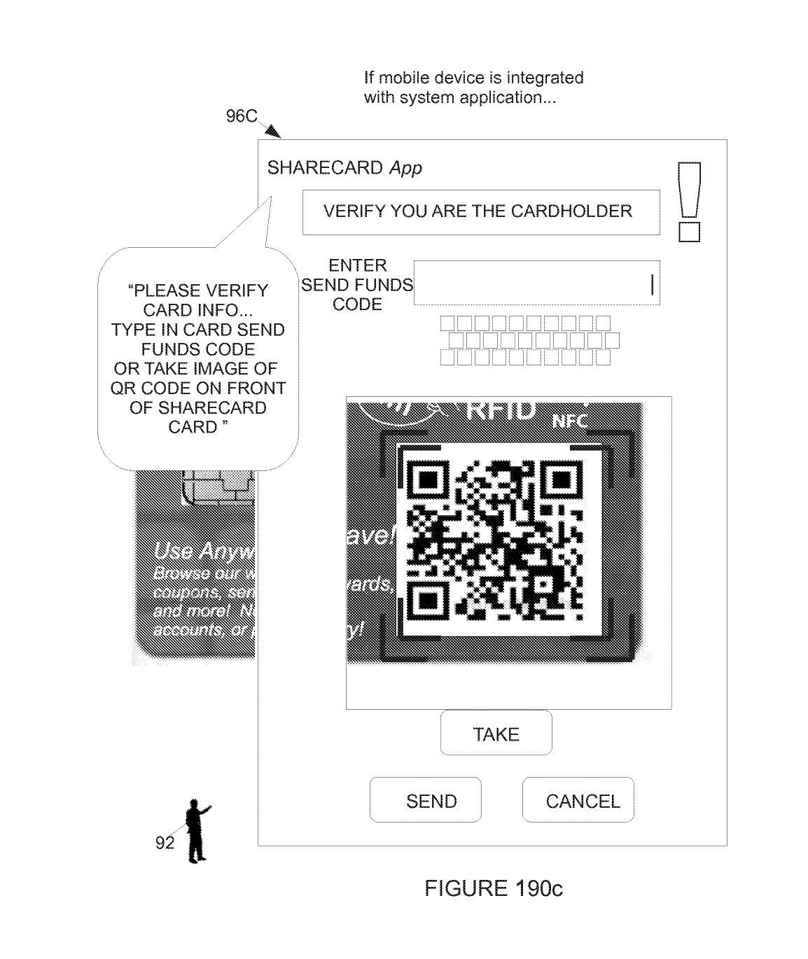

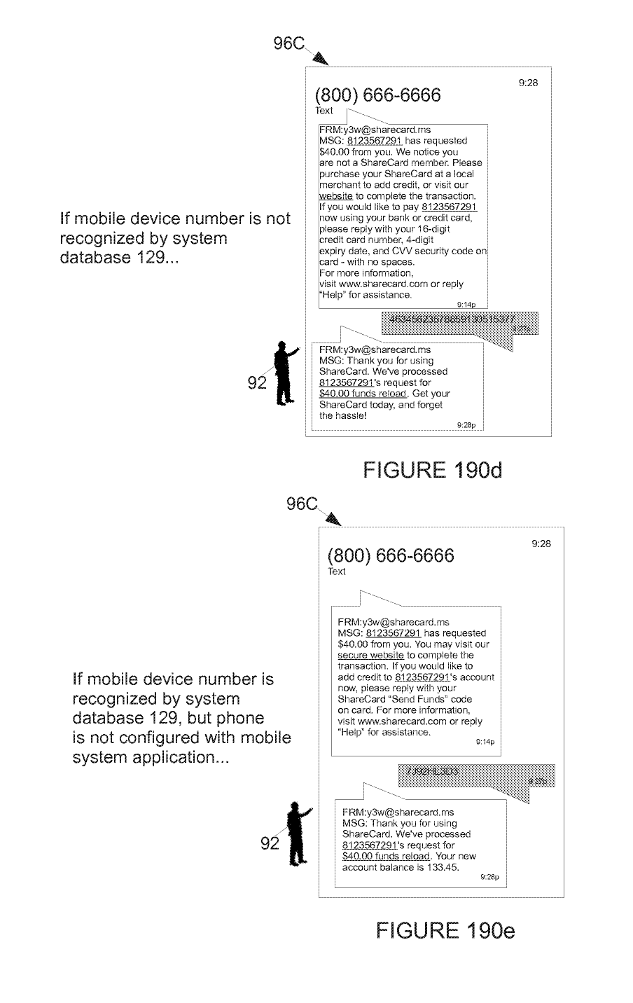

FIGS. 190d-190e suggest ways that non-users and users having mobile devices 96 which may not be supported by a system application may receive notifications, requests, pre-paid redemption options, redemption information 64, etc. The figures may also suggest various ways users and/or non-users may respond to other users of the system, without limitation.

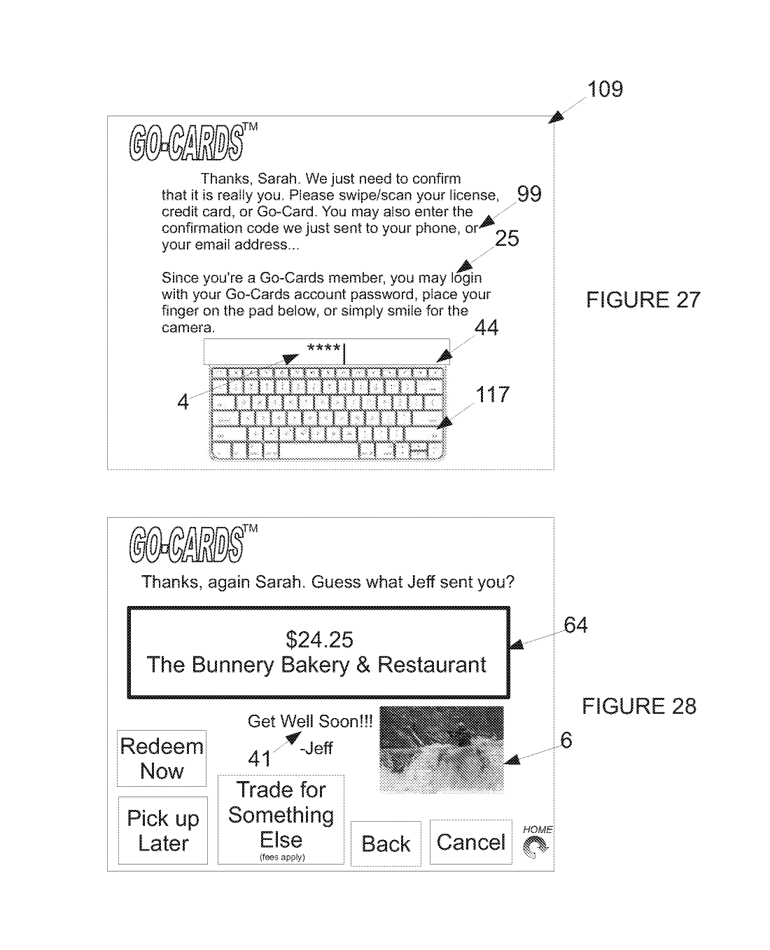

Embodiments of a system kiosk 3 may include one or more output devices such as electromechanical systems for producing and dispensing redeemable cash vouchers, electronic certificates, prepaid cards (e.g., phone cards), and one or means for display 109 (e.g., a display screen, such as an LCD screen, monitor, touch screen etc.) for displaying various options and prompts to users, and, in some embodiments, receiving customer inputs 4 such as user selections via a user interface 106 and data input means 117 (e.g., a touch keypad as shown in FIG. 27, interactive (i.e., “touchable”) images, indicia, icons, or prompts powered by a system-supported browser 131. A system kiosk 3 may include one or more action outputs 5. For example, one or more instructions, logical expressions, or functions, such as updates to user account or profile 130 information, information contained on a system 128 or external 122, 135, 136 servers or third party sites 93, 94 or software may be made as will be intuitive and apparent from this disclosure and the appended drawings.

Embodiments of a system-integrated kiosk 3 may include payment dispensing means 108 which may comprise means for wirelessly transferring one or more funds or credits, or types 72 of coupons, gift cards, vouchers, offers, currency, minutes, passes, tickets, codes, points, check information, currency, credit card information (e.g., receipt information) etc. to a wireless-enabled mobile computing device (e.g., a smart phone, tablet, gaming device, laptop, etc.) within a zone of acceptably close proximity of the kiosk (e.g., within distances of the kiosk 3 which are suitable for near field communication (NFC)).

Turning to FIG. 27, during a transaction with a system kiosk 3, a user 91, 92 may approach a kiosk 3 and observe the display means 109 and the user interface 106. The consumer may observe marketing information displayed through advertising means 107, or a light box containing marketing information pertaining to the system, the kiosk, brands of particular goods or services, or particular vendors or selling entities 65 participating with the system. The user then enters appropriate commands 4 associated with the kiosk to select one or more redemption options, which may include funds or credits which are to be associated with a card 19 manufactured and dispensed by the kiosk 3. The user interface 106 may employ simple or complex menus and a fixed set of keys or buttons for consumers to make their selections. The user interface 106 may employ break-resistant touch screens provided with entry fields and means, such as a touchpad, for providing information into the entry fields, or it may employ various combinations of keys, buttons, and touch screens. Once a selection has been made, the user may provide payment data 10 (e.g., in the form of cash, credit card, points, system-based credits, cryptocurrency, etc.) using the appropriate payment receiving means 100 provided to the kiosk 3 and, in response, the kiosk may provide the selected redemption option (e.g., via dispensing a card 19 associated with one or more funds or credits) to the user 91, 92, for example, without the need for further input 4 by the user 91, 92, and/or without additional human interaction.

The user 91, 92 of the system may provide one or more customer inputs 4 to a system-integrated kiosk 3. As will be described in more detail, customer inputs 4 may be made to a system website (e.g., via a mobile device 96, cell phone, mobile device, tablet, laptop, gaming device, etc.), made to one of a plurality of additional system-integrated kiosks 3, and/or a system-specific application (e.g., program or mobile app) which is designed to seamlessly provide a complete user experience with the system. The kiosk 3 may be provided in plain view at a venue/location 2. The venue/location may be, for example, any convenient site, such as an entrance or foyer of a mall, grocery store, airport, shopping plaza, public market, racetrack, or other convenient location, without restriction. Other examples of venues/locations where a kiosk 3 may be positioned may comprise, without limitation, locations where other purchases are made, popular points-of-sale, retail stores, restaurants, parks, churches, gas stations, convenience stores, and/or pharmacies. The kiosk may be placed separately from conventional checkout/registers, and therefore, they may be preferably configured to be used without secondary human interactions, particularly intervening human interactions which are conventionally required between a consumer and check-out clerk when activating conventional gift cards, conducting money transfers, wires, monetary exchanges, stock/fund trades, redemptions, etc.

During interactions with a system-integrated kiosk 3, a customer's inputs 4 may comprise many different types of data. For example, image data 6 (e.g., visual information) may comprise one or more pictures, graphics, images, photos, renderings, printed matter, and/or other conceivable forms of indicia. Image data 6 may be accepted by the kiosk from a user in many different ways, for instance, a kiosk 3 may, via internet/wireless network 118 or system client 162, access images which have been previously uploaded to the system website 127, for example via a user's profile 130. If linked to an account of a third party application 148, such as a social networking site 93, images may be populated on a kiosk 3 and displayed for user selection and editing (e.g., cropping). Image data 6 may be provided from a user's phone or mobile device 96 using near frequency communication (NFC) technology or via a hard cable 114 or other means for connecting to a mobile device 96. Image scanning means 102 may be used to input image data 6 from many types of printed materials and/or other articles according to user input(s) 4. Image data 6 may be provided to the system using a kiosk-based camera 116, scanning means 102, data input means 117, user interface 106 (e.g., via a system browser 131) or other imaging means or means for transferring image data 6 known in the art.

Audio data 7 may be provided as an input 5 to a kiosk 3. Audio data 7 may comprise, without limitation acoustic-based information such as an electronic sound file on a user's mobile device 96, the sound of the user's voice at a kiosk 3 or captured or otherwise obtained by a kiosk 3, a recording from a user 91, 91 made by the kiosk using audio input means 103, verbal instructions made by a user during interactions with a kiosk 3, one or more audio files previously uploaded to a system website 127 by a user via their system profile 130 or other conceivable account access page, an audio file sent to a user's mobile device 96 from another user of the system or sent to a user by the system or kiosk 3 itself, audio which may be wirelessly accessed and played back from a user's mobile device during kiosk interactions, real-time audio from a user of the kiosk or real-time audio presented by another user which is remote from a kiosk 3 (e.g., who is speaking with a user of a kiosk 3 via mobile device 96 during kiosk interactions, or who is co-currently communicating audio to audio input means 103 of another remote system-integrated kiosk), or a kiosk-provided sound file which is selected by the user after one or more kiosk prompts. Audio data 7 and/or information associated therewith may be delivered, received, and/or used by a user in different manners while interfacing with a kiosk 3, or with a participating entity 95. For example, audio data 7 may be used for security or verification purposes at a system kiosk 3, or at the point-of sale at a participating entity. Voice-recognition software may be implemented in system kiosks 3 to facilitate immediate user access to system information, account access, redemption data 64, and use of funds or credits associated with a card 19 or system account. Audio data 7 may be communicated through the system via system-integrated software 147 (e.g., a mobile application on a user's mobile device 96 which is supported by the system), and may be shared between system network components (e.g., networked kiosks 3, entity payment receiving means 100, mobile devices 96, computers 95, system servers 122, entity servers 136, financial institution servers 122, external servers 125, etc.).

In another example, two different users of the system may share or otherwise communicate audio-containing messages, dial tones, digital tones, or sound waves sent via email or voicemail which may be used as verification/authenticating/security means for one or more particular transactions. One non-limiting example of how this may be accomplished is by having a first user 91 record a prompted or spontaneous vocal message, script, passage, or saying using audio input means 103 at a first system kiosk 3 as a first part of a transaction regarding a distribution of funds or credits to a second user 92. The system may store the recorded message as a “sound key” on a system-integrated database 129. The recorded message (i.e., “sound key”) may then be sent by the system to the second user's 92 voicemail (i.e., the intended recipient) in an audio format; or, alternatively, the recorded message sent may comprise a system-specified predetermined cropped portion (i.e., “clip”) of the recorded message and may be sent to the second user 92 in the form of audio or a viewable, visually displayable, image of a sound-wave/sine-wave pertaining to the clip of the recorded message. The second user 92 may bring up the audio file or image depicting the audio data 7 (i.e., the sound key), and may present it to a kiosk 3 local to the second user 92 or to payment receiving means 100 of a participating entity during instant redemption of one or more purchased product/offering/services 151. In the former aforementioned case, the audio data 7 in the form of a voicemail may be played back to audio input means 103 of a system kiosk 3 local to the second user 92, in order to verify that the transaction is valid and redeem the funds or credits from the first user 91. In the latter aforementioned instance, the second user 92 may bring up the image depicting the system-cropped audio file on his/her mobile device 96. Using image scanning means 102 and/or camera/image capture means 116 provided to a system kiosk 3 local to the second user 92, the system may capture the image depicting the system-cropped audio file from the second user's mobile device 96. A comparison of the second user's sound key with the image stored in the system database 129 obtained from the first user 91 may be made to authenticate the second user 92's identity.

It is anticipated that audio data 7 and/or image data 6 may be used in different manners to verify transaction authenticity and validity of redemption data 64. For example, a user possessing redemption data 64, e.g., on the user's mobile device 96 to be used at a point-of-sale at a participating entity 65 may be additionally prompted at the point-of-sale, for a verification code. At this time, the system may automatically relay (or allow the user to manually select the option to relay) auto-generated image data 6 (e.g., QR code, bar code, graphic, image), or sound wave (e.g., digitone) from the user's mobile device 96 (e.g., via MMS, or system application 147) which may be received (and optionally displayed, simultaneously played, delay played, or observed) by entity personnel and/or the entity's payment system-supported/networked receiving means 100. The auto-generated image 6 or audio 7 data may be randomly generated by the system in much the same manner as secure SMS protocol is done for online banking. A verification of the user's image data 6 or audio data 7 may be made by the entity's payment system (i.e., supported/networked receiving means 100). If there is a match between the user-provided image 6 or audio 7-based data and the image 6 or audio 7-based data received by the payment receiving means 100, then the redemption data 64 is authenticated and the transaction is validated. In this regard, redemption data 64 may be stored in a dumb format (e.g., descriptive in nature of the product/offering/service 151 for redemption) until the exact time of desired use, where the actual redemption data 64 is sent to the holder of redemption data 64. Accordingly, even if a user's email account is hacked or hijacked, or if a user's printed redemption data 64 is lost or stolen, a transaction utilizing the redemption data cannot be completed other than by the user and their mobile device 96.

In yet another embodiment, a real-time transaction of funds or credits may be made between a first user 91 at a first system kiosk 3 and a second user 92 at a second system kiosk 3. A meeting time may be set between the users 91, 92 using means outside of the system, or a meeting time may be initiated by the system and delivered to each user 91, 92 using any form of communication (e.g., text, email, phone message, autodialer call, message displayed via a system application 147, etc.). A meeting may be requested or initiated by a second user 92, or a meeting may be requested or initiated by a first user 91. During the transaction between the first 91 and second users 92, image data 6, such as real-time webcam video image data 6 obtained by image capture means 116 provided first and second system kiosks 3 may be communicated between the first and second system kiosks 3 so as to authenticate visual identification of a sender and/or recipient (i.e., one-way visual identification or two-way visual identification). The first user 91 may ask a security question and may receive a response from the second user to validate that the receiving party 92 is correct, so that the transaction may be completed.

One particular example of how the system may be used is when a second recipient user 92 approaches a system kiosk 3 and requests a type 72 of funds or credits from a first user 91 at another system kiosk 3. The first user visually confirms the recipient's identity, and the requested transfer of funds or credits to the second user 92 may be completed by the system using one or more customer inputs 4 from the first user, such as purchase data 9 and payment data 10. Updates 27 are made within the system (e.g., adjustments to the first user's 91 financial information, profile 130 information, system-recognized credit balance, account information, etc.), and a portion or all of the funds or credits are delivered to the second user 91 electronically (e.g., to their system account, financial information, profile 130 information, system-recognized credit balance, account information, etc.) or physically (e.g., via a dispensed card 19, or other type 72 of article, such as a paper coupon, voucher, currency (digital or physical), ticket (e.g., lottery ticket), and the like. One or more system fees may be applied per transaction, and such fees may be adjusted based on the type 72 of funds or credits distributed.

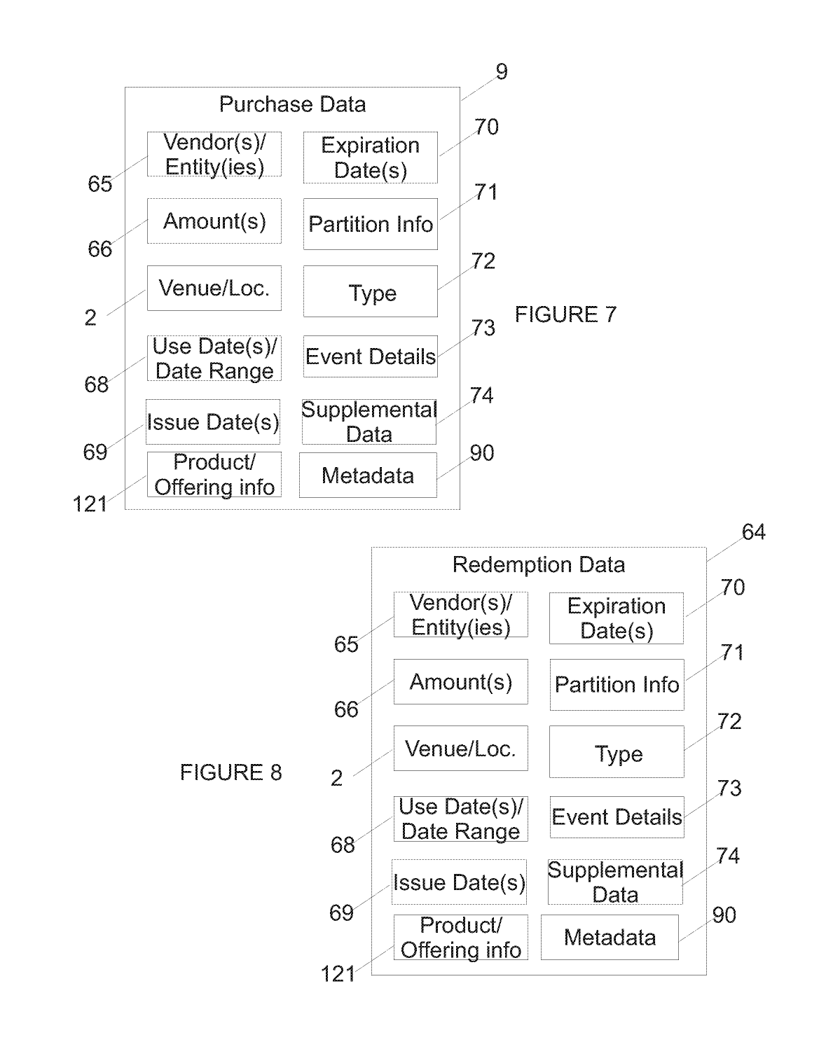

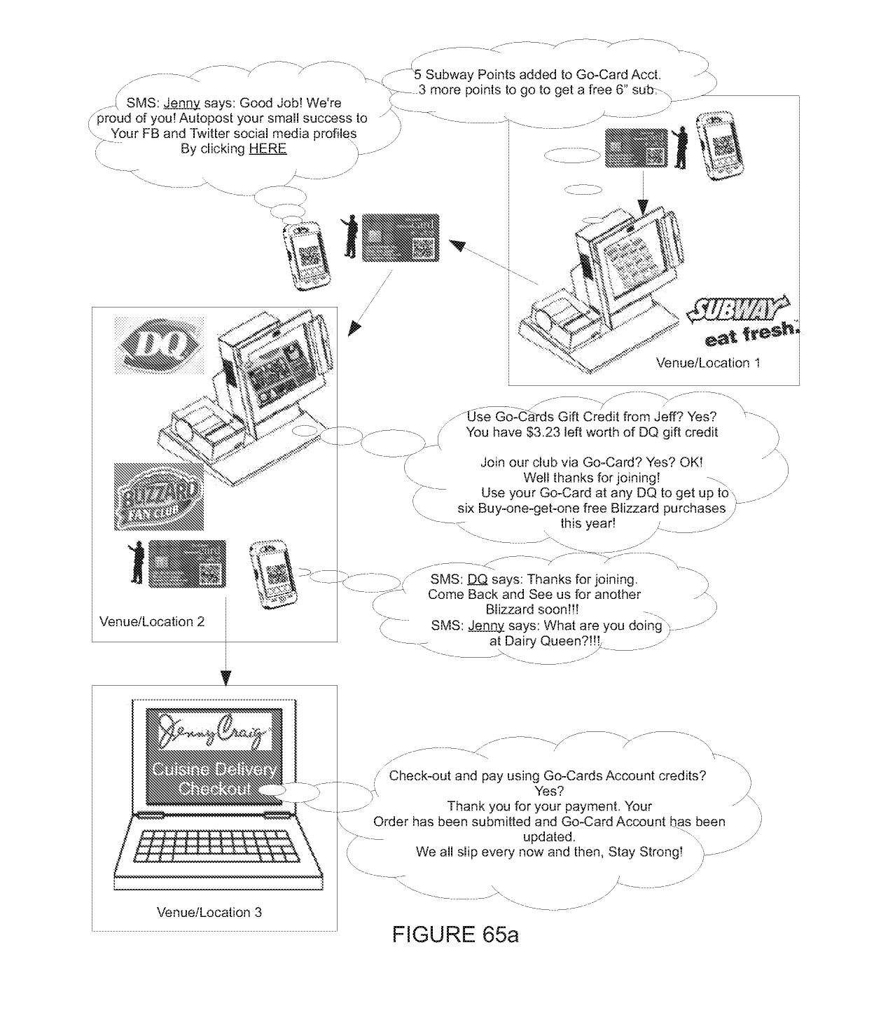

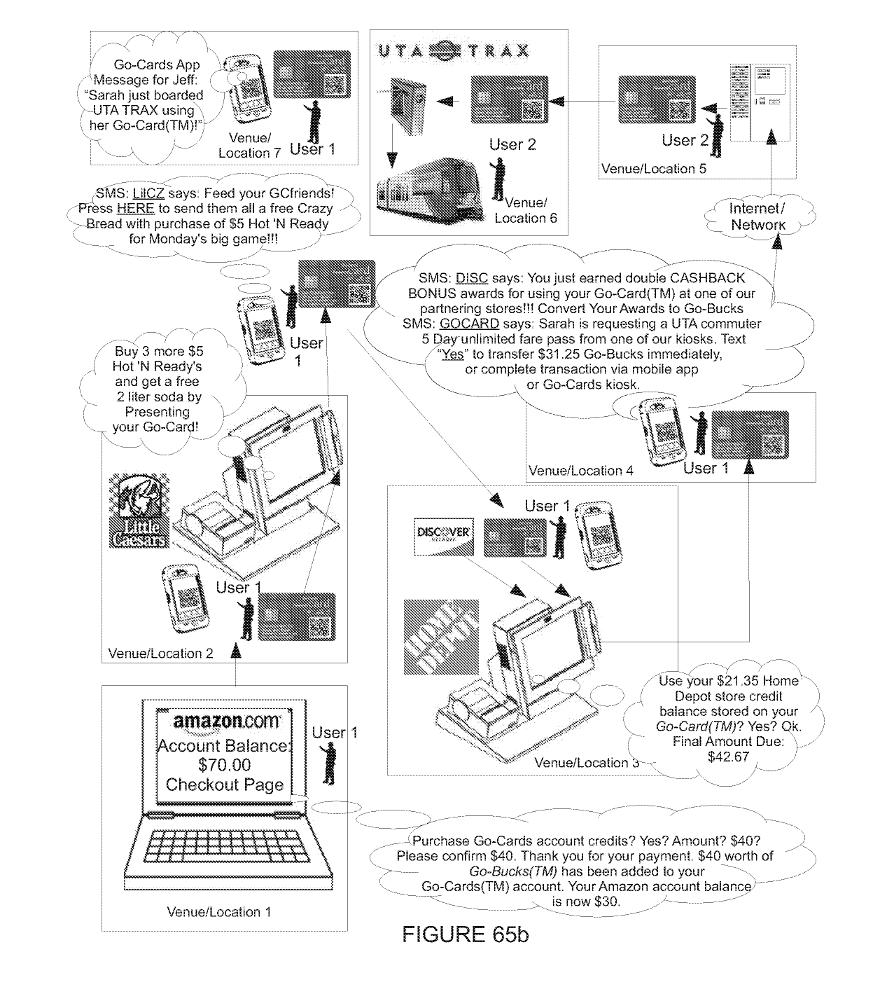

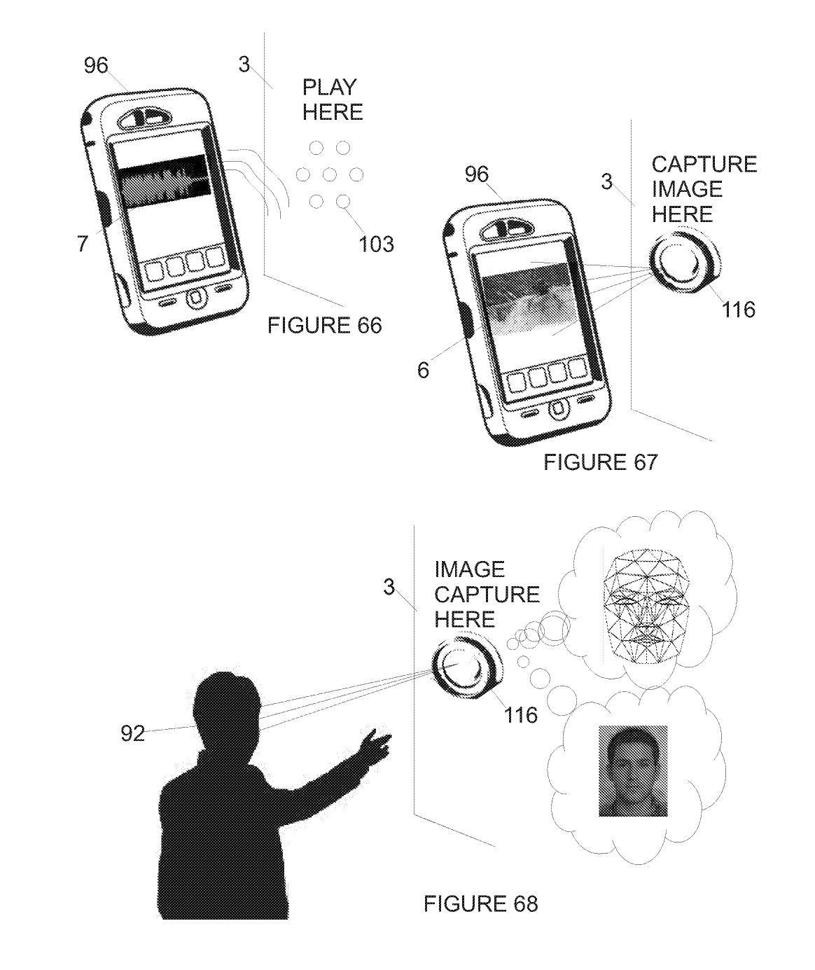

If a kiosk 3 is not available for use, or if a kiosk 3 is currently busy attending to other users, such video web transactions between a first 91 and second 92 users which are facilitated by the system using real-time image data 6 may take place over the internet via the system website 127. This may, for instance, be done through a system application 147 provided on a computer 95 or mobile device 96 of the first 91 and/or second 92 user. For example, a transfer of funds or credits may take place through system software 147 which incorporates a system-proprietary, or third party video chat platform or application 148 (e.g., Skype, Gmail chat, etc.). One particular example of this may be when a second recipient user 92 accesses a system application 147 from their mobile device, and requests funds or credits from a first user 91 which may be providing funds or credits. As shown in the upper right portion of FIG. 65B, an SMS or other message, such as a message delivered by a system application 147 may be received by the first user 91 which indicates the request made by the second recipient 92. The message may be provided to the first user 91 via the first user's 91 mobile device 96 and/or computer 95. The first user 91 may visit a system kiosk, or address the request from his/her mobile device 96 or computer 95, depending on which vehicle is most convenient. The message may contain audio 7 or visual image data 6 confirming the recipient's identity, or the message may provide the first user 91 with the option to instigate a real-time video chat with the second user 92. Using system-supported software 147, the first user 91 may be presented with the requested type 72 or amount value of funds or credits, without limitation. The first user 91 may be presented with information pertaining to one or more vendors or entities 65 which are related to the request made by the second user 92. Means for approving the request, such as a “confirm” or “accept” icon, button, or link may be provided to the first user 91 via the system software 147. Means for approving the request may comprise one or one or more instructions to the first user 91 which are necessary to complete the transaction. Such instructions may include one or more prompts for secondary user inputs 4, such as authorization information 60 (e.g., a password/passphrase, token, key, security code, answer to a security question, etc.). Means for declining the request may be provided to the first user 91 in a similar manner as the means for approving the request. Once the first user 91 accepts the request made by the second user, one or more updates 142 are made within the system (e.g., updates to the first 91 or second 91 user's system account information, financial information, profile 130 information, system-recognized credit balance(s), etc.). Updates 142 may include recording purchase data 9 (e.g., FIG. 7) into the history 146 of the first user's profile 130, and recording redemption data 64 into the profile 130 of the second user's profile 130. The second user 92 may subsequently make use of the redemption data 64 (e.g., FIG. 8). When the redemption data 64 is utilized or otherwise redeemed by the second user 92 in full or part, metadata 90 and/or other information regarding the use of redemption data 8 by the second user 92 may be recorded in the history 146 of the second user's 92 profile 130.

User data 8 and other information relating to a user of the system, system website 127, system application 147 (e.g., desktop version or mobile version), or kiosk 3 may be provided to a system-integrated kiosk apparatus 3 described herein. As shown in FIG. 6, such user data 8 may comprise information relating to one or more: names 47 or name information of purchaser(s) and/or recipient(s), phone numbers 53 or phone information (e.g., carrier, plan, usage information) of purchaser(s) and/or recipient(s), account numbers 48 or account information of purchaser(s) and/or recipient(s) (e.g. system account number or account number of a third party website or program such as a social networking site 93), addresses 54 or address information (e.g., street, residence number, city, state, country, county, location, hemisphere) of purchaser(s) and/or recipient(s) (e.g., home, place of business, legal residence for tax purposes), email address(es) 49 of purchaser(s) and/or recipient(s), bank or credit card number(s) 55 or bank or credit card information (e.g., expiry date, company information, account information, account use information, security code information, signature information) of purchaser(s) and/or recipient(s), shopper loyalty/club/rewards/membership number 56 or information (e.g., entity information, “membership since” information, visit history information, past purchases information) of purchaser(s) and/or recipient(s), birth date 50 or birth date information of purchaser(s) and/or recipient(s) (e.g., century, decade, year, month, day, hour, second, hospital, location), driver's/professional/certification or other license number 57 or license information of purchaser(s) and/or recipient(s) (e.g., state, country, organ donor information), biological/biometric information 51 of purchaser(s) and/or recipient(s) (e.g., iris pattern information, fingerprint information, vein pattern information), passport information 52 of purchaser(s) and/or recipient(s) (e.g., passport number), identification card information (e.g., alien residence card information, student ID card information, id card number) of purchaser(s) and/or recipient(s), authentication/security information of purchaser(s) and/or recipient(s) (e.g., password information, security key information, encryption key information, security token), the purchaser(s) in general, the recipient(s) in general, and/or preferences of purchaser(s) and/or recipient(s), without limitation.

Purchase data 9, such as information relating to a particular purchase made by or intended to be made by a user 91, 92 of the system, system website 127, third party website, system app 147, or system-integrated kiosk 3 may be entered as part of customer inputs 4. Purchase data 9 may relate to funds or credits discussed throughout this description. FIG. 7 suggests some non-limiting types of information that purchase data 9 may include. For example, purchase data 9 may contain, without limitation, information regarding one or more vendors or entities 65, expiration dates 70, amount(s) or value(s) purchased 66, venue or location 2 information (e.g., information regarding where goods, offerings, or services were purchased or otherwise obtained), type 72 of purchased goods, offerings, or services, valid dates 68 of use of purchased goods, offerings, or services, event detail(s) 73 pertaining to purchased goods, offerings, or services, issue date(s) 69 regarding information about when goods, offerings, or services were purchased, supplemental data 74 including miscellaneous information (e.g., regarding instructions on how to purchase, terms and conditions of purchase, comments from the entity 65, and/or method of purchase—whether it be by mobile system application 147, via system website 127 or kiosk 3), specific products, offerings, and services 121 purchased or to be purchased (including those which are generic, niche/custom, branded, or the like in nature), and/or metadata 90 relating to purchased or goods, offerings, or services 151 to be purchased (e.g., via shopping list(s) 144). If multiple purchases are made by a user 91, 92 of the system, partition information 71 may be utilized in the organization of purchase data 9. For example, partition data 71 may include information regarding pointers, arrays, matrices, tables, or strings, of information or other logical organizational means of arranging, storing/containing, or accessing purchase data 9. Redemption data 64, such as information relating to a particular redemption made by or intended to be made by a user 91, 92 of the system, system website 127, third party website, system app 147, or system-integrated kiosk 3 may be entered as part of customer inputs 4. Redemption data 64 may relate to funds or credits discussed throughout this description. FIG. 8 suggests some non-limiting types of information that redemption data 64 may include. For example, redemption data 64 may contain, without limitation, information regarding one or more vendors or entities 65, expiration dates 70, amount(s) or value(s) to be redeemed 66, venue or location 2 information (e.g., information regarding where goods, offerings, or services may be purchased, redeemed, or otherwise obtained using redemption data 64), type 72 of redeemable goods, offerings, or services, valid dates 68 in which purchased goods, offerings, or services may be redeemed, event detail(s) 73 pertaining to redeemable goods, offerings, or services, issue date(s) 69 regarding information about when redeemable goods, offerings, or services were initially purchased, supplemental data 74 including miscellaneous information (e.g., regarding instructions on how to redeem, terms and conditions regarding redemption(s), comments from the entity 65, and/or method of purchase—whether it be by mobile system application 147, via system website 127 or kiosk 3), specific products, offerings, and services 121 redeemed or to be redeemed (including those which are generic, niche/custom, branded, or the like in nature), and/or metadata 90 relating to redeemed or redeemable goods, offerings, or services 151 (e.g., via shopping list(s) 144). If multiple redemptions are made by a user 91, 92 of the system, partition information 71 may be utilized in the organization of redemption data 9. For example, partition data 71 may include information regarding pointers, arrays, matrices, tables, or strings, of information or other logical organizational means of arranging, storing/containing, or accessing redemption data 9.

Payment data 10 such as information relating to a form of funds or credit may be entered as customer input 4. Payment data 10 may comprise information relating to cash-based currency 11 (e.g., cash, money, domestic currency, foreign currency, paper money, coin, legal tender, treasury note, money order), or credit card credits 12 (e.g., VISA, AMEX, DISCOVER, MASTERCARD, other credit-based account information or data). Payment data 10 may comprise information relating to debit card/electronic benefits transfer cards 13 (e.g., debit card, welfare/benefits card, electronic money, electronic funds transfer EFT card, bank card, or information relating thereto). Payment data 10 may comprise information relating to checks (e.g., personal check, cashier's check, bank check, corporate check, payroll check, tax refund check, corporate check). Payment data 10 may comprise information relating to gift cards (e.g., gift card (e.g., purchased online, bought at store, given to by third party), voucher, rain check, vendor-accepted funds or credit, gift certificate, system account card/kiosk-manufactured card, system-gift card, transferable or purchasable rewards/loyalty points, transferable or purchasable frequent flyer miles) Payment data 10 may comprise information relating to a coupon or code 16 (e.g., a coupon, code, alphanumeric code, bar code, indicia associated with a discount, group discount coupon, vendor or entity-accepted funds or credit, sale code, savings code, online coupon code, promotional deal code, authorization code, frequent flyer miles). Payment data 10 may comprise information relating to an account number (e.g., bank account number, frequent shopper account, membership account number, credit card number, system user account number, financial assistance account number, account number rewards account number, customer account, escrow service account number, payment system account number (e.g., PayPal, merchant account, acquiring bank account number). Payment data 10 may comprise information relating to digital or electronic currency (e.g., Bitcoin, cryptocurrency, digital gold/DGC currency, etc.)

After customer inputs 4 are received by a system-integrated kiosk 3, one or more outputs 5 may be produced by the kiosk 3. The outputs 5 may include one or more actions facilitated by the kiosk 3 or they may include delivering one or more manufactured articles via various mechanisms provided to the kiosk 3. One or more of the outputs 5 may be delivered immediately upon user interaction with the kiosk, and/or one or more of the outputs 5 may be delivered at a later time. One or more of the outputs 5 may be delivered to a purchaser or first user 91, and/or one or more of the outputs 5 may be delivered to a recipient or second user 92. For example, an output 5 may include dispensing a card 19 produced by a system-integrated kiosk 3. Output 5 may comprise information 129 pertaining to a card 19 which is to be produced by a second system-integrated kiosk 3. The information 129 may be used during transactions, shopping interactions, and payments with a variety of vendors or entities 65. The information 129 may be accessed and re-accessed in a variety of manners, for example, via a system website, user application, computer, mobile device, system kiosk 3, or via use of the card 129 at a participating entity.

According to some embodiments, cards 19 produced by a system kiosk 3 may comprise a number of different types of cards (e.g., open loop/network card, closed loop card, hybrid closed loop card, rebate card, Mags Pangilinan-type cash card, restricted monetary equivalent card, scrip card, pre-paid phone card, bank-issued gift card, credit card company-issued gift card, integrated circuit ICC card, smart card, RFID card, contactless card, magnetic stripe/magstripe card, electronic card, embossed card, printed card, keycard, access card, badge card, proximity card, stored-value card, security card, credential card, common access card, CR80.30 Composite PVC-PET card, high coercivity magnetic stripe PVC card, CR80.13 mil graphic quality PVC card, low frequency (LF) RFID card (e.g., 125 kHz, 26, 34, 35, 36 & 37-bit formats), high frequency RFID card (e.g., 13.56 MHz MiFare ultralight, 1K, 4K, Desfire, etc.), ultra high frequency card (e.g., 840 to 960 MHz), MiFARE card (e.g., 4K, 1K, mini cards), ultralight and ultralight C RFID key card, EM4100/EM4102 system-supported card, BLANK NXP MiFare RFID card, chip card, ISO 7816-compliant contact card, multicomponent card, memory card, CPU/MPU cards, vault card, fingerprint card, dual interface card, 12 mil plastic card, 30 mil plastic card, plant-based card (e.g., by Ingeo)), without limitation. However, in more preferred embodiments, the cards preferably include one or more smart communication features which are broadly compatible with a variety of commonly-implemented vendor payment systems. Other preferred embodiments include PVC or similar plastic cards which are commonly used for financial transactions, identification, badges, key cards, and the like.

Cards 19 discussed herein may have applied thereon one or more stickers, for example, conventional graphic stickers, scratch and sniff stickers, stickers having one or more appliable PIN “scratch-off” stickers having a removable masking layer applied thereon. For example, a front or rear portion of the card may have an account number or pin or other printed matter thereon which is covered by a temporary peel off sticker or clear sticker comprising a “scratch off”-type removable opaque material layer applied thereto to expose the underlying account number or PIN or other printed matter. Such stickers may be provided to card blanks which are delivered to kiosks 3, or the stickers may be added or otherwise provided during production of a card 19 by a kiosk 3. Such stickers may be applied to tickets, passes, receipts, and/or any other physical article produced by the kiosk 3 (other than traditional currency).

Outputs 5 may include providing one or more receipts 20, via receipt delivery means 141, which may be delivered to a user (e.g., purchasing user, recipient user, repeat user, or new user) of the system in various forms, including electronic and physical (e.g., traditional paper-based) forms. For instance, receipts 20 may be auto-stored electronically on a user's profile 130 in a system database 129 (e.g., in a user history 46) for convenient access, organization, without causing negative environmental impacts and identification theft which may be associated with paper receipts 20. Receipts 20 may be printed by printing means 104, which may form a portion of receipt means 141. Another output 5 may be or may comprise a generated email 21, such as an auto-generated email or other electronic message to a properly-networked supporting device (e.g., caller identification or other television screen messaging display technology). For example, automated email messaging may be triggered upon a kiosk-facilitated purchase by a user, or may be triggered upon receiving one or more kiosk outputs 5 or making one or more inputs 4. An email 21 may be generated each time a card 19 produced by a kiosk 3 is used, wherein the email 21 may contain information about the card's use, thereby eliminating the need for a paper receipt, reducing exposures to identity theft, and simplifying digital records management.

Outputs 5 from kiosk 3 interactions may include the delivery of a confirmation number or confirmation code 22, such as an auto-generated code. Such a code 22 may be used for online or in-person transactions, PINs, discounts, verification, security, and/or records retention. Outputs from interactions with a kiosk 3 may comprise the delivery or sending of one or more text or image-based messages 23 via SMS/MMS-based messaging systems. Such messaging outputs 5 may be performed automatically, or in accordance with one or more user preferences 63, and may provide a mechanism for paperless receipt. Outputs 5 from kiosk 3 interactions may comprise the delivery or sending of voicemail messages 24. Such voice-messaging may be performed automatically, or in accordance with one or more user preferences 63. Outputs 5 from kiosk 3 interactions may comprise the delivery or sending of physical messages 25, for example, a fortune message, a greeting card, a gift card holder/envelope, postcard, or the like.

In some embodiments, a kiosk 3 may provide postage 26, for example, in the form of printed postage, pre-determined/weighed postage, or a stamp dispenser as part of outputs 5. Currency 27 (e.g., cash, money, paper money, bill(s), coin(s), digital/electronic currency, domestic currency, foreign currency, legal tender, treasury note(s), money order information, etc.) may be delivered to a user of kiosks disclosed herein as an output 5. The currency 27 may be delivered to a user as change for a purchase, or as a redemption of a gift from another user of the system.

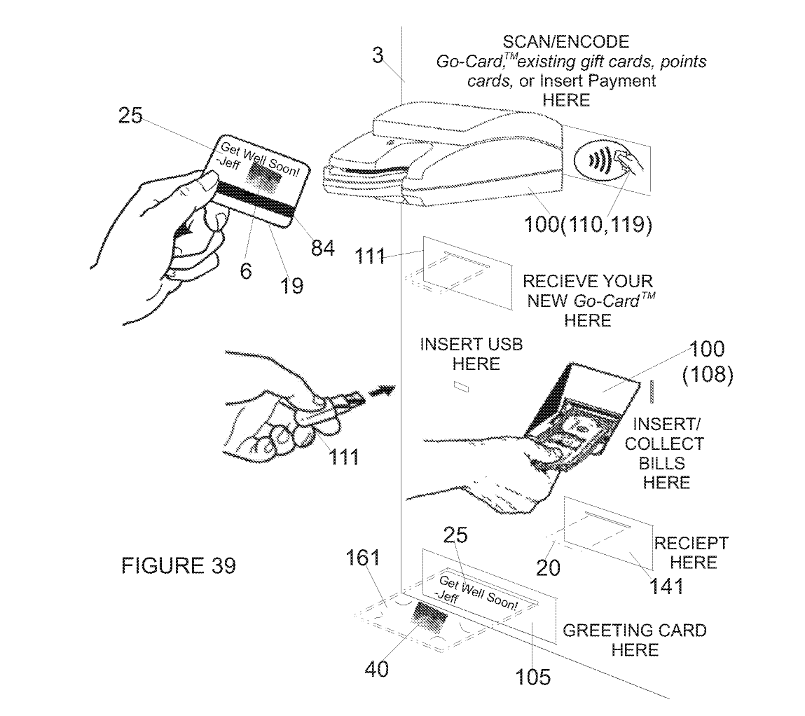

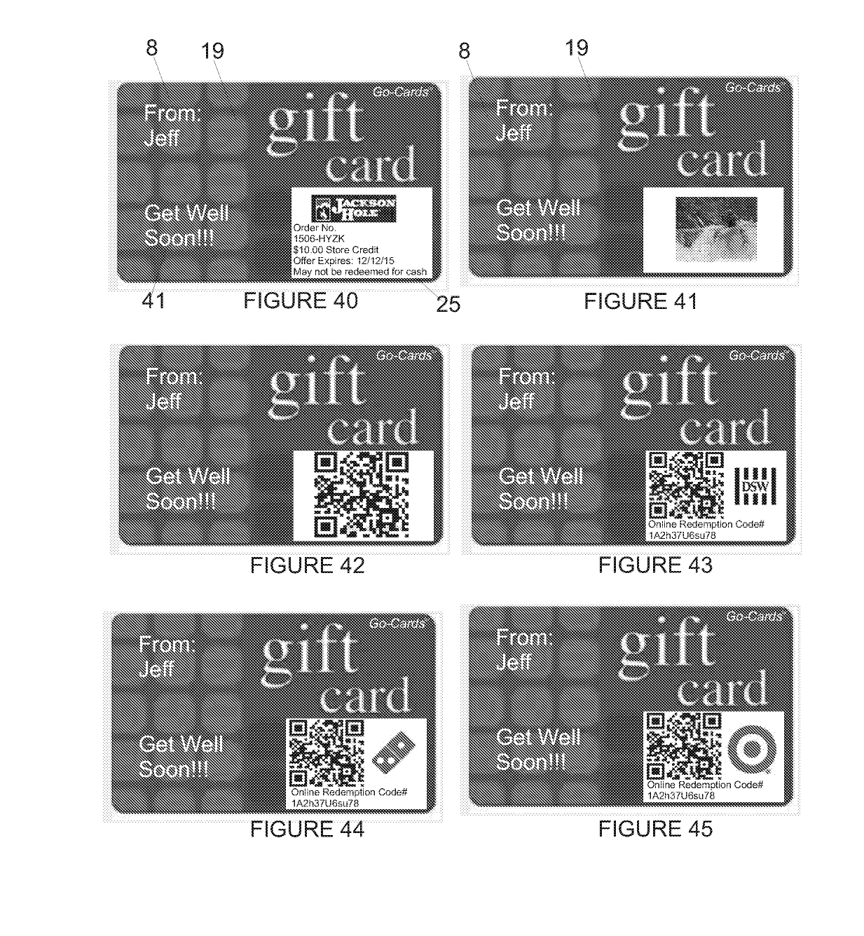

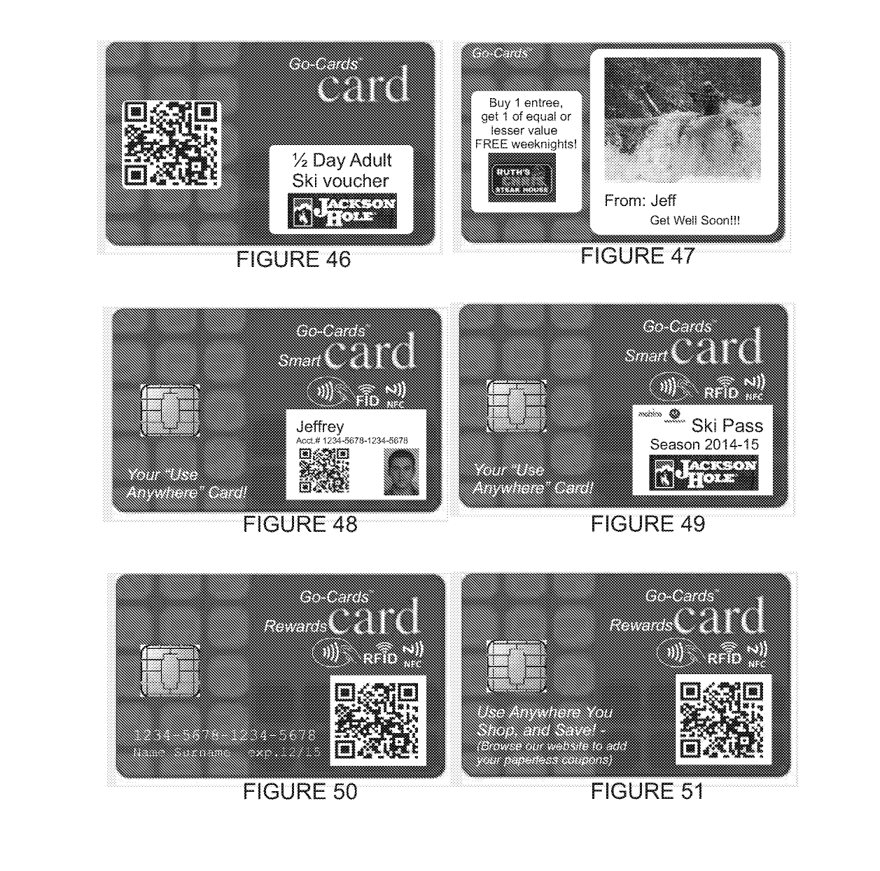

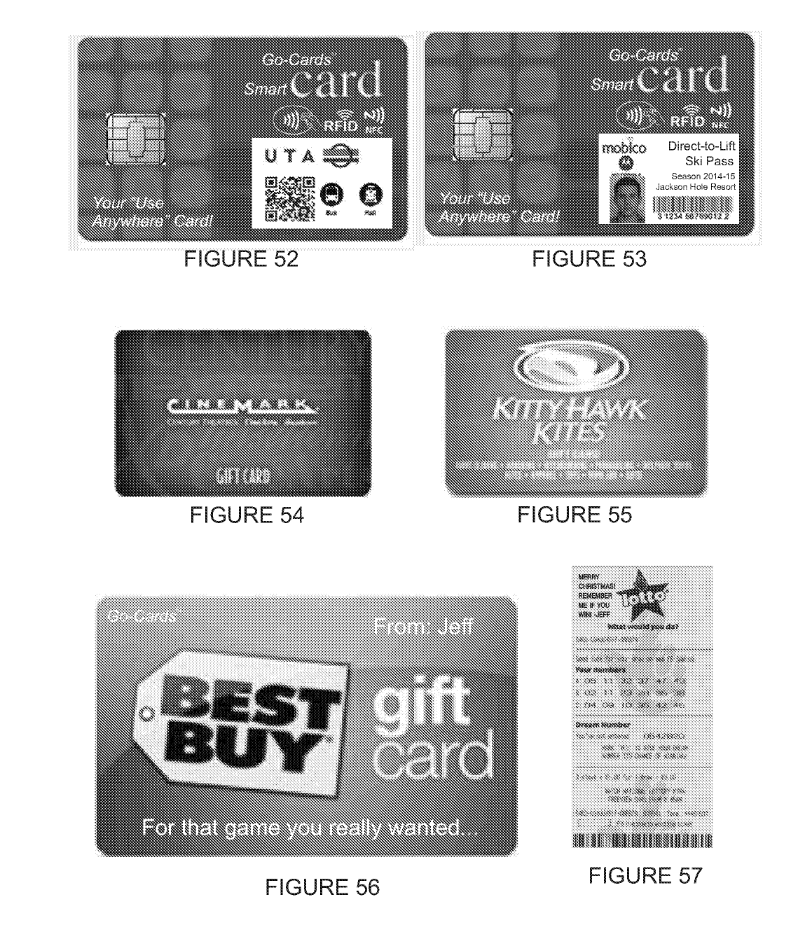

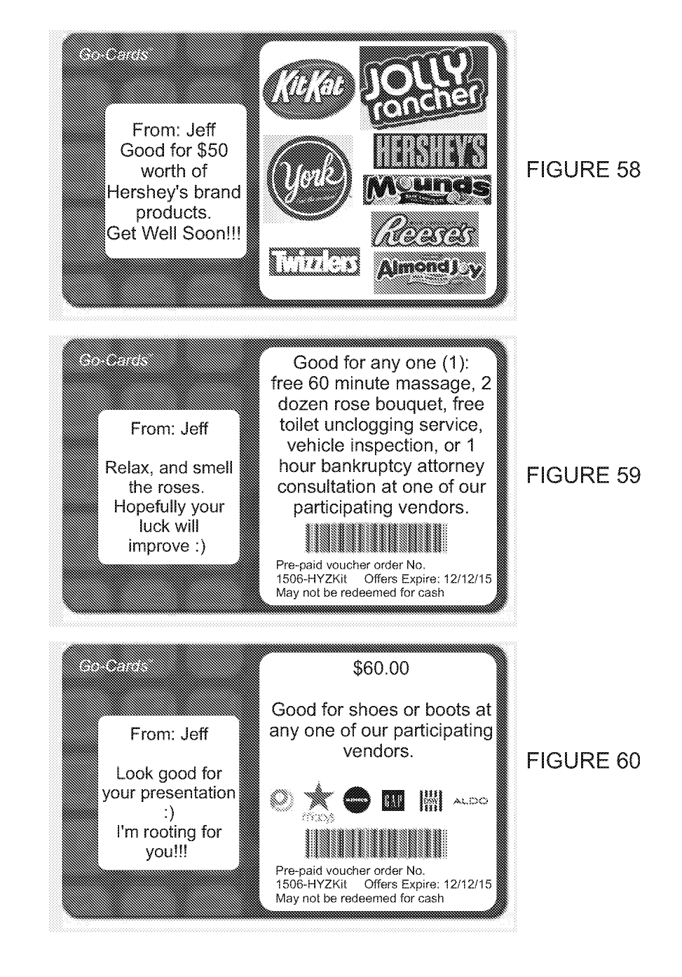

In some embodiments, a kiosk 3 may output a greeting card 161 or the like. The greeting card 161 may be printed from card stock, blank paper, photo paper, or other form of stationary. The greeting card 161 may comprise self-mailing means such as one or more fold lines, a “lick and stick” web of adhesive, a peel off sticker having removable backing, pressure sensitive adhesive, or one or more tab-in-groove interlocking features (as commonly found in boxed foods packaging), without limitation. Greeting card 161 may comprise an integral envelope or envelope which is separately delivered to the user by the kiosk 3. Alternatively, while not shown, envelope storage means may be provided to a kiosk 3 for a user to take from a supply of envelopes (as typically done for conventional ATMs). In some preferred embodiments, as will be appreciated from FIG. 39, greeting card 161 may comprise card holding means such as a number of perforations, slots, slits, pockets, apertures, tape, glue, or other sticky substance, or the like for attaching a card 19 produced by the kiosk 3. Greeting card production means 105 provided to a kiosk 3 may be used independently of other kiosk features, uses, and functionalities. In some instances, greeting card 161 may comprise one or more security features such as a password, passphrase, or security question for the recipient to answer before a card 19 produced by a kiosk is activated. Greeting card 161 may comprise customer service information, information regarding activation of a card 19, one or more user instructions, user data 8 such as address 54 and/or name 47 information, message information 41, image data 6, or audio data 7 (e.g., a visual representation of a sound wave or link/address to a user-recorded audio or video). Postage 25 may be calculated or pre-defined by the kiosk, and dispensed in the form of conventional stamps, or printed postage. Printed postage, may, for example, be provided directly onto a portion of the greeting card 161, envelope, and/or card 19 itself. Postage may be provided on a printed sticky label which may be dispensed by a kiosk 3 and which may be provided with a peel off backing layer. The sticky label may be applied to the greeting card 161, a card 19 produced by the kiosk 3, or envelope for mailing. Postage may be digitally stored on a card 19 produced by a system kiosk or otherwise provided to a card 19 during manufacturing of the card (e.g., in the form of external indicia). Postage-based operations, functions, actions, and outputs may be facilitated using respective postage means 120 provided to the kiosk 3.

Another kiosk 3 output 5 may comprise one or more updates 142, which might include one or more updates to customer input(s) 4, one or more updates to information associated with an intended recipient's system account, one or more updates to the system website 127, one or more updates to a system database(s) 129, one or more updates to system-supported application software 147 which may be used within the CPU 97 of the kiosk 3, or on a user's mobile device 96 or computer 95, one or more updates to a financial institution database(s) 138, one or more updates to an external institution database(s) 135, one or more updates to a vendor or entity's database(s) 137, one or more updates to a social media site(s) 93, one or more updates sent to an advertising group/ad client/research firm 94, one or more updates to location data 143, payment data 10, purchase data 9, redemption data 64, etc.

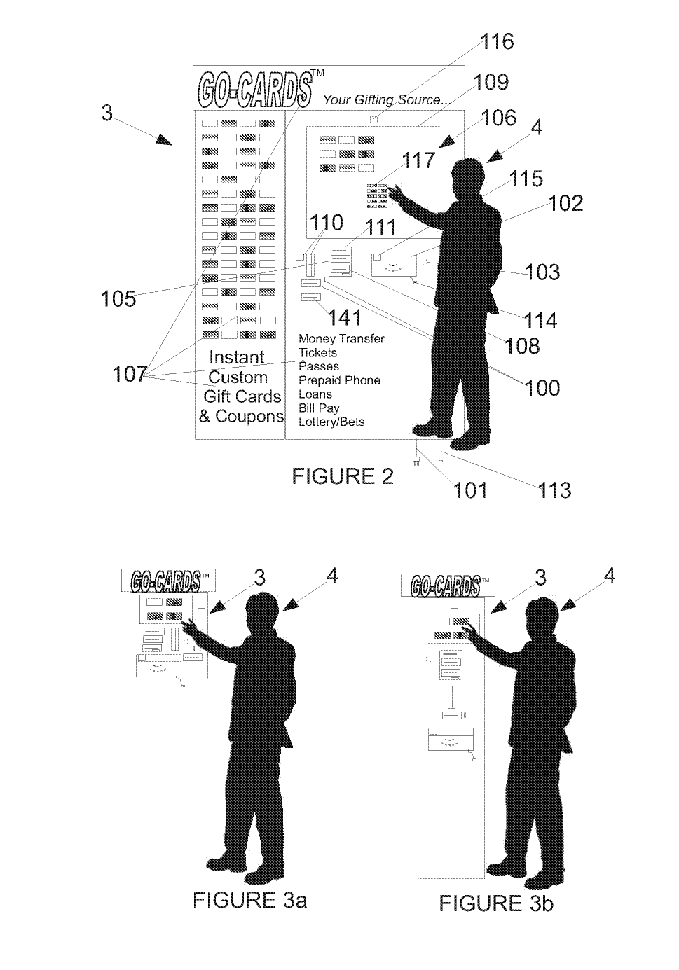

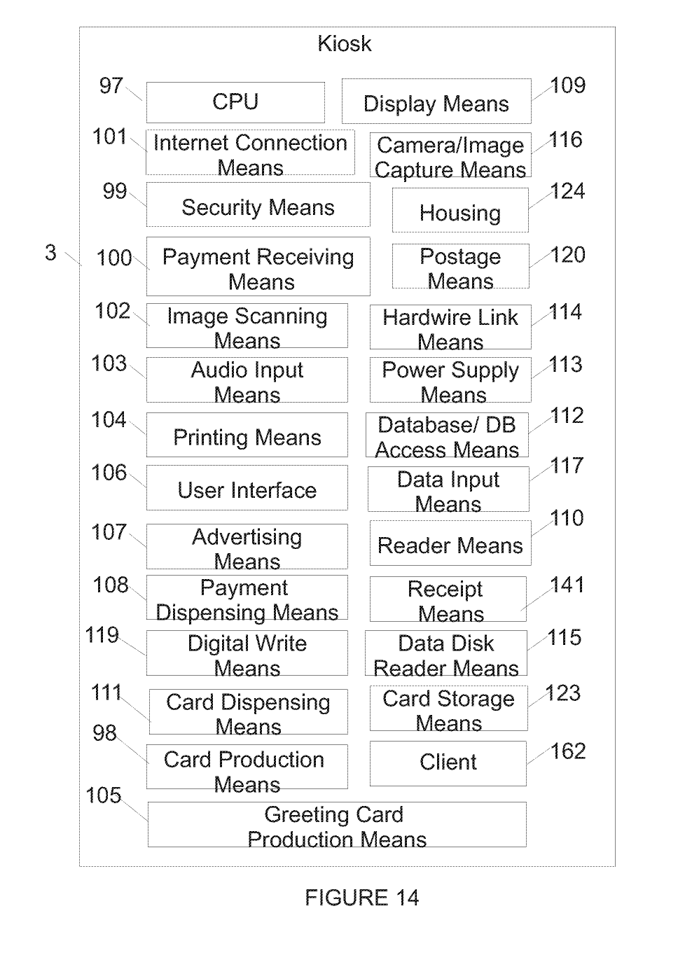

FIGS. 2, 3a, and 3b show various conceivable non-limiting configurations of system-based kiosks 3 that are in accordance with some embodiments. It is foreseen that mini-kiosks which lack one or more of the described features may be employed. For example, a kiosk may be provided in a small compact unit which may be displayed adjacent a conventional gift card display rack. Such a mini-unit may be utilized by a customer to determine if a particular vendor is located at a recipient's location. For example, a mini-kiosk associated with the system may be provided with image scanning means 102 which is configured to read bar codes and/or other indicia or graphic provided on conventional gift cards displayed on a typical gift card display rack. A user may enter information regarding a recipient's location (e.g., address) on the mini-kiosk and then scan a conventional gift card displayed on the display rack. The mini-kiosk may allow the user to see if there are any locations of the particular vendor that exist near the recipient, and if so, may provide the distance between the recipient and the particular vendor location. A wand scanner with flexible cord may be provided as part of the image scanning means 102 so that the user may scan multiple displayed conventional gift cards over a large area. FIGS. 14, 25, and 39 suggest some non-limiting examples of what kiosk apparatus 3 may comprise, according to certain embodiments.

For instance, a kiosk 3 may comprise a central processing unit (CPU) 97. The CPU 7 may comprise such things as one or more motherboards, hard drives, integrated circuit boards, memory (e.g., RAM), memory storage devices, processors, operating systems, internet browser 131-supporting hardware and software 147, internet protocol suite/TCP/IP network supporting hardware and software, video cards, sound cards, network cards, programs, system/control/address/data buses, generic computer hardware, system-supported software 147, RS232 serial ports, USB ports, PCMCIA slots, disk slots, parallel ports, infrared IRDA ports, terminals, keyboard/keyboard wedge interfaces, peripherals (e.g., keyboard(s), mouse(s)), drivers, logic and command interpretations, power supply(ies), cooling devices, processors, heat sinks, and/or other components, instructions, and executables typically found within computing devices. The CPU 97 may be associated with a client 162 which is configured to communicate with one or more system servers 128. The CPU 97 may comprise internet or other network connection means 101 for communicating with other devices, system devices (e.g., kiosks 3, payment receiving means 100, payment dispensing means 108), platforms, system applications 147, third party applications 148, and/or other components of the system linked to the internet and/or other communication network(s) 118 (e.g., 3G UMTS CDMA-based networks, 4G LTE OFDMA-based networks, TCP/IP internet protocol suite-based networks, Global System for Mobile Communications/GSM networks, Global Positioning System GPS networks, General Packet Radio Service/GPRS networks, cdmaOne networks, CDMA2000 networks, Evolution-Data Optimized/EV-DO networks, Enhanced Data Rates for GSM Evolution/EDGE networks, Universal Mobile Telecommunications System/UMTS networks,

Digital Enhanced Cordless Telecommunications/DECT networks, Digital AMPS/IS-136/TDMA networks, Integrated Digital Enhanced Network/iDEN networks, Long-Term Evolution/LTE networks, High-Speed Downlink Packet Access/HSDPA networks, WiMAX networks, WCDMA networks, Internet Protocol Version 4/IPv4-based networks, Internet Protocol Version 6/IPv6-based networks, etc). The CPU 97 may facilitate most kiosk 3 operations and functions, such as receiving inputs 4 from a user 91, 92, delivering outputs 5, performing updates 142, and facilitating transactions described herein in general, as will be appreciated by those skilled in the art. A kiosk 3 according to certain embodiments may comprise card production means 98. Card production 98 means may comprise any printing means 104 suitable for printing on, encoding, producing and/or delivering a manufactured card 19. For instance, card production means 98 may comprise any one or more of the features or technologies described in U.S. Pat. No. 5,673,076, WO1999021713, WO1997039424, WO1999021713, WO2000016235, WO2000027634, WO2000043932, WO2003029117, WO2004089633, WO2004089634, WO2005001601, WO2005026908, WO2005122057, WO2007050768, or WO2012090163, without limitation, the aforementioned publications being incorporated by reference herein.

Card production means 98 may comprise or operatively communicate with card storage means 123 to draw a card blank for printing. Card storage means 123 may comprise, for instance, one or more hoppers, magazines, or cartridges which are suitably configured to hold a predetermined number of card blanks. Though not preferred, it is anticipated that card storage means 123 may comprise a stock of perforated, semi-perforated, or non-perforated card blanks, such as a roll of card blanks which are cut on demand using a progressive automated die. In some instances, card storage means 123 may be configured with multiple hoppers, magazines, or cartridges which are each designated to hold a particular type of card blank. For example, certain magazines may store dumb (e.g., plastic-only) cards, certain magazines may store smart cards (e.g., with magnetic stripe 87, or smart chip 86, solid state device 85, or tag device 88, such as an RFID-based tag, transponder device). Card production means 98 may be integrated with the CPU 97 and other automation equipment within a kiosk 3 to select an appropriate card blank from the appropriate card storage means 123, and provide image data 6, user data 8, purchase data 9, redemption data 64, payment data 10, to the card blank to produce a custom card 19 to a user of the system. The data may be provided to the card using a card printer and/or digital write means 119. Digital write means 119 may comprise one or more different types of encoding means which is configured to load a card blank, a kiosk-dispensed card, or a user held card 19 manufactured by another kiosk 3 at an earlier time with information. In some embodiments, digital write means 119 may comprise any one or more of the following: a magnetic stripe writer/encoder, an EMV IC chip writer, an ISO/IEC 15416-compliant write device, an ISO/IEC 15426-2 compliant write device, an SO/IEC 15415-compliant write device, an ISO/IEC TR 29158-compliant write device, a radio frequency/RFID writer, a smart chip writer, an integrated circuit writer, a security authentication device writer, a device capable of loading smart-card-based single sign-on (SSO) supported software, an EMV device writer, a contactless “smart” article writer, an inductor-comprising device writer, or the like, without limitation. For example, digital write means 119 may comprise a magnetic writer/encoder which may comprise any one or more of the features or technologies described in EP0209811, EP0721174, EP0837413, WO1999064985, CN102521551, WO1990005961, WO1990009642, WO1991010953, WO1998052153, WO1999028851, WO2000016235, WO2000042568, WO2001088659, WO2001099046, WO2003019460, WO2004012352, WO2005116913, WO2009085393, WO2010022129, WO2010031253, WO2013081635, WO2013112839, U.S. Pat. No. 4,128,851, U.S. Pat. No. 4,146,174, U.S. Pat. No. 4,755,069, U.S. Pat. No. 5,101,097, U.S. Pat. No. 5,302,893, U.S. Pat. No. 5,397,886, U.S. Pat. No. 7,793,851, U.S. Pat. No. 7,931,195, U.S. Pat. No. 8,302,872, and/or U.S. Pat. No. 8,413,892, without limitation.

Kiosks 3 described herein may be provided with security means 99, which may comprise or otherwise support one or more encryption/decryption tactics, authorization protocols, security algorithms, cryptographic/cryptologic algorithms, cryptosystems, plaintext to ciphertext encryption and decryption software, key/cipher-based protocols, secure code validation techniques known in the art, symmetric key cipher protocols, secure remote access/secure shell SSH client programs/network protocols and similar built-in architectures, transport layers, user authentication layers, connection layers, public key cryptography systems, RSA/DSA key exchanges, secure copy SCP protocols, FTP/SFTP transfer protocols, cryptographic hash functions, data encryption standard DES-compliant encryption algorithms, advanced encryption standard AES-compliant algorithms, public key infrastructures, modular multiplication/exponentiation means, Bitcoin client software (e.g., open source code), P2P networking protocols, encoding schemes, digital wallet security features, block-chain accessing functions, digital currency exchange client software, or the like, without limitation.

Payment receiving means 100 may be provided to kiosks 3, system website 127, system software 147, and/or to participating vendors/entities 65 (including participating entity websites) described herein. Payment acceptance means 100 may comprise software, hardware, and/or physical apparatus for accepting payments, funds, or credits. Payment receiving means 100 may comprise, for instance, one or more bill receiving and identification systems, coin receiving and identification systems, electronic funds transfer acceptance systems, currency acceptance mechanisms, electronic funds transfer or credit card acceptance devices, coupon code validation and acceptance software/hardware, gift card validation and acceptance software/hardware, credit/debit card acceptance terminals, electronic funds transfer/point-of-sale/EFT-POS terminal, hardware/software components of an EFT-POS terminal, magnetic stripe readers, EMV/VSDC/Mchip/AEIPS/Jsmart/D-PAS acceptance terminals, secure online payment submission web pages, secure checkout pages, digital wallet acceptance terminals, digital currency exchange client software, contactless payment systems, payment due calculating software/hardware, electronic payment software or systems, credit adjusting software, account information updating software, payment applications, wireless smart phone swipe crediting systems, mobile tap and go device or sticker systems (e.g., MasterCard PayPass, VISA PayWave), smart phone/digital device payment applications (e.g., Wells Fargo or Bank of America app), and various combinations thereof, without limitation.

Internet/network connection means 101 may be provided to a system kiosk 3. Internet/network connection means 101 may comprise, for instance, one or more Ethernet-compatible devices, wireless network WAN devices, LAN cables (e.g., of the category 5 RJ-45-type), LAN/WAN/GAN/3G/4G/LTE/LTE advanced compatible devices, IP network addresses, wired (e.g., Ethernet) or wireless (e.g., Wi-Fi-based) routing devices, routers (e.g., ADSL), fiber optic hubs, internet protocol suite TCP/IP-compatible devices, ISP software/hardware, IP networking device, modem device (e.g., USB broadband, ADSL), local servers, hubs, ports, switches, network distributors, wire-enabled network cards (internal or external), peripheral component interconnect (PCI) connections, industry standard architecture (ISA) connections, wireless-enabled network cards/NIC (internal or external/USB), internet service providers (ISP), firewalls (e.g., built-in, hardware, or software-based), or the like.

Image scanning means 102 may be provided to kiosks 3. Image scanning means may comprise, for instance, one or more charge-coupled device (CCD) imagers, CCD readers, contact image sensor (CIS) devices, laser scanners, electronic devices which are configured to scan printed or handwritten text documents, images, or a particular object and convert them into one or more digital images, optical scanners, flatbed scanners, rotary scanners, planetary/orbital scanners, 3D scanners, time-of-flight 2D laser scanners, time-of-flight 3D laser scanners, digital camera scanners, document scanning applications/software/hardware, non-compressed RGB image processing means, raster graphics programs, optical character recognition OCR software, sceyeX document cameras, lenses, filters, light sources, photodiodes, light-emitting diodes (e.g., infrared LEDs), light or ultrasound non-contact active scanners, laser emitting devices, laser triangulation sensors, conoscopic systems, position sensitive devices, structured light 3D scanners, consolidated light 3D scanners, stereoscopic systems, photometric systems, silhouette technique imaging devices, modulated light 3D scanners, acousto-optic deflectors, electro-optic deflectors, one dimensional laser scanners, two-dimensional laser scanners, resonant galvanometer scanners, rotating mirror polygon scanners, rotary encoders, vertical cavity surface-emitting laser (VCSEL)-containing scanners, imaging scanners, video camera readers, large field-of-view readers, omni-directional 1D or 2D barcode scanners/readers/position sensors, QR code readers, data matrix code readers, third party smart phone-type barcode scanner applications (e.g., Google Goggles, Scan, Nokia Symbian, Maemo mbarcode, proprietary barcode scanning apps, BlackBerry App World, Windows Bing search app, etc.), universal product code UPC scanners, pen/wand scanners, pen-type readers, stationary scanners, handheld scanners, camera-type readers, fixed position scanners, PDA scanners, Auto-ID PDA scanners, maxima/minima algorithms, symbology decoding algorithms, automatic readers, cordless scanners, decoding algorithm(s), serial interfaces, keyboard/mouse port interfaces, USB connector interfaces, wireless networking means, ISO/IEC 15416-compliant read devices, ISO/IEC 15426-2 compliant read devices, SO/IEC 15415-compliant read devices, ISO/IEC TR 29158-compliant read devices, biometric portable acquisition computer (i.e., B.P.A.C.) devices (e.g., by Maxvision), devices which are configured to read B.P.A.C.-compatible biometric information/data, fingerprint scanning devices with associated hardware and software, retinal (i.e., iris) scanning devices with associated hardware and software, facial recognition-compatible cameras with associated hardware and software, voice recognition software, eye movement scanning devices with associated recognition software, palm vein authentication systems/readers/infrared hemoglobin detectors with associated recognition software (e.g., PalmSecure™ device by Fujitsu), or the like, without limitation. Audio input means 103 may be provided to a kiosk or kiosks 3. For example, in some embodiments, kiosks 3 may comprise one or more microphones, VoIP-compatible devices and/or associated software, electromagnetic induction devices, acoustic-to-electric transducers, acoustic-to-electric sensors, piezoelectric devices, fiber optic devices, micro electrical-mechanical system (MEMS) devices, speaker devices, wireless audio devices, microphone interfaces, calibration means, audio/sound filters, blimp/zeppelin devices, windscreens, wires, or the like, without limitation.

Printing means 104 may be provided to kiosks, without limitation. According to some embodiments, printing means may be used to print on card blanks to produce a custom card 19. According to some embodiments, printing means 104 may be used to print greeting cards 162. According to some embodiments, printing means 104 may be used to print receipts 20, tickets (e.g., lottery tickets—see FIG. 57). Printing means 104 may comprise one or more card printers, embossers, liquid ink/inkjet printing devices, dye-sublimation printing devices, ink-less/thermal printing devices, laser printing/etching devices, impact printing devices, line matrix printer devices, electrostatic printing devices, photographic printing devices, electrolytic printing devices, spark printer devices, barcode printing devices, retransfer card printing devices, laminating devices, dye-sublimation retransfer devices, dye-sublimation thermal transfer direct-to-card printing devices, reverse image technology printing devices, thermal rewrite printing devices, non-impact printing devices, multi-function (MFP) printers, digital printer hardware, digital printer drivers/software, printer command languages, page description languages, card printers (e.g., card printers from Zebra, Evolis, Magicard, Datacard Group, Fargo, Nisca, Epson, Arojet, Dem-Jet UVA, Disen, ETA card, or ID Maker), ink/toner cartridges, or the like, without limitation.

Cards 19 that are printed via printing means may be dispensed via card dispensing means 111 (e.g., printer tray, delivery mechanism) prior to or after encoding by digital write means 119.

Greeting card production means 105, which may be provided to a system kiosk 3, may comprise one or more of the printing means 104 described above. For example, greeting card production means 105 may comprise one or more toner-based printers, liquid inkjet printers, solid ink printers, dye-sublimation printers, ink-less printers, line printers, laser printers, dot-matrix printers, line matrix printer/comb printers, electrostatic printers, pen-based plotters, thermal printers, laser etching printers, blank cards for printing on, stationary for printing on, paper cards for printing on, envelopes for printing on, mechanized rollers, electromechanical mechanisms for dispensing greeting cards 162, or the like, without limitation.

A system kiosk 3 may comprise a user interface 106. The user interface may comprise one or more of the following alone or in various combinations: a graphical user interface GUI, a human machine interface HMI, a human-computer (HCI) interface, a man-machine (MMI) interface, a schemata device, a web-based user (WUI) interface, a touch screen, a control panel, a keyboard (physical or tactile/touch-based), a mouse, a palm-sized tracking ball or roller, a command line interface, a touch user interface, a haptic feedback mechanism, an attentive user interface, a batch interface, a conversational interface, a crossing-based interface, a gesture interface, an intelligent user interface, a motion tracking interface, a multi-screen interface, a non-command user interface, a canonical window system-based interface, an object-oriented user (OOUI) interface, a reflexive user interface, a tangible user interface, a task-focused interface, a text-based user (TUI) interface, windows, icons, menus, pointer interface (WIMP), a voice user interface, a natural-language interface, a zooming user interface, or other mechanisms of an interface which allow a user to communicate with a kiosk 3, or provide one or more user inputs 4 to the kiosk 3 to obtain a desired output 5. Advertising means 107 may be provided to a system kiosk 3, system website 127, system-supported software 147 (e.g., computer programs and/or mobile applications), to cards 19 and other types 72 of physical or digital articles (e.g., receipt 20) produced by the system or components thereof, throughout the system in general. Advertising means 107 may comprise one or more of the following: integrated marketing management software, customer insights and feedback processing software, qualitative algorithms, analytics software, customer relationship management CRM/SaaS software/systems, aggregate transaction information storage and access means, data collection software, B2C marketing automation tools/systems, inbound marketing automation tools/systems, search engine optimization (SEO) tools, social media marketing SMM applications, social software applications, marketing automation tools/systems, voice-based marketing automation (VBMA) applications/software platforms, lead generation software, lead tracking software, lead scoring software, lead routing software, lead nurturing software, lead reporting software, CRM integration systems, hosted interactive voice response software, API integration protocols, software analytics-enabled software, SMS/MMS messaging software and networking solutions, online advertising management platform components, adware/advertising-supported software, promotions, logos, offers, advertisements, subliminal imaging, pop-up ads, adware, suggestive marketing, targeted marketing tactics, browser advertising, advertisement software, ad-enabled browsers, ad-enabled search toolbars, keystroke monitoring software, and various combinations thereof, without limitation. Advertising means 107 may involve graphical information, audio information, video information, and other forms of media used to advertise products, goods, services, offerings, deals, incentives, promotions, and the like, without limitation.

Payment dispensing means 108 may be provided to kiosks 3, system website 127, system software 147, and/or to participating vendors/entities 65 (including participating entity websites) described herein. Payment dispensing means 108 may comprise software, hardware, and/or physical apparatus for disbursing, refunding, or crediting payments, funds, or credits. Payment dispensing means 108 may comprise, for instance, one or more physical payment dispensing devices, electronic payment delivering means, change calculating software/hardware, electronic payment/crediting software or systems, credit adjusting software, account information updating software, payment applications, wireless smart phone swipe crediting systems, mobile tap and go device sticker systems (e.g., MasterCard PayPass, VISA PayWave), smart phone/digital device payment applications (e.g., Wells Fargo or Bank of America app, one or more bill identification and dispensing systems and mechanisms, coin identification and dispensing systems, electronic funds transfer delivery systems, currency conveyance mechanisms, electronic funds transfer or credit card crediting or transferring devices, coupon code validation software, coupon issuance/re-issuance software/hardware, gift card validation and issuance/re-issuance software/hardware, credit/debit card acceptance terminals, electronic funds transfer/point-of-sale/EFT-POS terminals, hardware/software components of an EFT-POS terminal, magnetic stripe writers, EMV/VSDC/Mchip/AEIPS/Jsmart/D-PAS acceptance terminals, secure online payment submission web pages, secure checkout pages, digital wallet acceptance terminals, digital currency exchange client software, contactless payment systems, and various combinations thereof, without limitation.

Display means 109 may be provided to kiosks 3. Display means 109 may comprise one or more LCD screens, LED/OLED screens, plasma display devices, touch screens, electroluminescence EL devices, gas discharge displays, photoluminescence devices, incandescence devices, rear projection devices, television screens, monitors, projector devices, laser projection displays or the like for displaying information to a user 91, 92 of the system. Preferably, display means 109 may comprise a touch screen which may include an clear protective film thereon. An optional shade curtain may be provided to the kiosk housing 124 adjacent the display means 109 so as to allow easier viewing in sunny outdoor locations, or locations where glare may negatively impact a customer's experience.

Kiosks 3 and other components of the system (such as user mobile devices 96, venues or locations 2, or one or more physical locations within a brick-and-mortar entity 65) may comprise reader means 110. Reader means 110 may comprise any one or more of the following: magnetic stripe readers, radio frequency/RFID readers, smart chip readers, integrated circuit readers, security authentication device readers, single sign-on SSO device readers, EMV device readers, contactless “smart” system device readers, inductor-comprising device readers, ISO 7816-compliant readers, MagTek, Inc. readers, ISO 14443-compliant readers, MiFare protocol readers, wireless smart phone swipe readers, mobile tap and go device sticker system readers (e.g., MasterCard PayPass, VISA PayWave), and various combinations thereof, without limitation. Reader means 110 may interact with cards 19 produced by kiosks 3, user mobile devices 96 supporting system-based applications 147, and/or products 151 or product data 121 (e.g., markings, barcodes, and smart RFID tags on products) within the inventory of a entity 65. As will be described hereinafter, cards 19 produced by kiosks 3, user mobile devices 96 supporting system-based applications 147, and/or products 151 or product data 121 may interact with active inventory management systems, and/or security systems 156 of vendors/entities 65.

Kiosks 3 may comprise an onboard database and/or database access means 112 to access a system database 129 stored on a system server 128. Databases utilized by the kiosks 3 and system components may comprise one or more database management system (DBMS), SQL-compliant devices, ODBC-compliant devices, JDBC-compliant devices, supporting database structures, database model(s), database servers, multitasking kernels, networking support modules, RAID disk arrays, XML models, application software, application programming interfaces, NoSQL/NewSQL databases, document-oriented databases, key value stores, in-memory databases, active databases, database triggers, cloud databases, data warehouses, deductive databases, distributed databases, document-oriented databases, embedded database systems, end-user databases, federated database systems, multi-databases, graph databases, triple-stores, network databases, hypertext databases, hypermedia databases, knowledge base databases, mobile databases, customer databases, parallel databases, shared memory architectures, shared disk architectures, shared nothing architectures, probabilistic databases, real-time databases, spatial database, temporal databases, terminology-oriented databases, object-oriented databases, unstructured data databases, and combinations thereof, without limitation. Database access means 112 may comprise means for accessing one or more external databases 135 (e.g., of social network corporations 93, advertising entities 94, or other large data corporations (e.g., Google)), entity databases 137, financial institution databases 138, and the like. Similar database access means 112 may be provided to the system website 127, system server 128, and system-integrated applications/software 147.

In order to power kiosk functions, kiosks 3 may comprise power supply means 113, such as one or more hardwired power cables connected to the grid, inverters, mains leads, plugs, converters, adapters, fuses, or interrupters. In some embodiments, hardware link means 114 may be provided to a kiosk to receive or transfer customer inputs 4 or charge a user's mobile device (i.e., “charging station”). A kiosk may provide a free charge of a mobile device 96 in exchange for a charge, or in exchange for participating in a customer survey, market survey, or download of a system application. Hardwire link means 114 may be utilized to download information from a user's mobile device 96 which is not configured for wireless (e.g., NFC) communication with the kiosk 3. Hardware link means 114 may be provided at a convenient location for user access. For example, hardware link means may exit the housing 124 for connection to a user's mobile device 96 at or around waist or chest level. Hardwire link means 114 may comprise any cables and/or interfaces which are compatible with mobile devices (e.g., parallel ports, serial cables, general purpose interface (GPIB) buses, cable connectors, small computer system (SCSI) interfaces such as ISIS, universal serial bus (USB) connectors, FireWire connectors, proprietary interfaces, applications programming (API) interfaces, SANE, TWAIN, Windows image acquisition (WIA) components, and various combinations thereof). According to some embodiments, hardwire link means 114 may comprise protective covers, universal connectors, stretchable (i.e., coiled) cords, hangers or wraps for cables, or retractable cables, without limitation.

Data disk reader means 115 may be provided to accept user inputs 4 from a drive. In some embodiments, data disk reader means 115 may comprise one or more flash memory readers, solid state drive SSD readers, SD card readers, microSD card readers, USB flash readers, compact disk readers, DVD readers, or other type of reader which is configured to read data storage devices. Data input means 117, such as a touch screen, digital stylus, keyboard (physical or touchpad), voice recognition system, speech transcription system, speech-enabled interface, online data entry page, web-fillable HTML form, user prompt screen, data entry field, or the like may be provided to the kiosk 3, in addition to other forms of input means described herein (e.g., camera/image capture means 116, scanner means 102, reader means 110, user interface 106, audio-input means 103, display means 106, etc.).

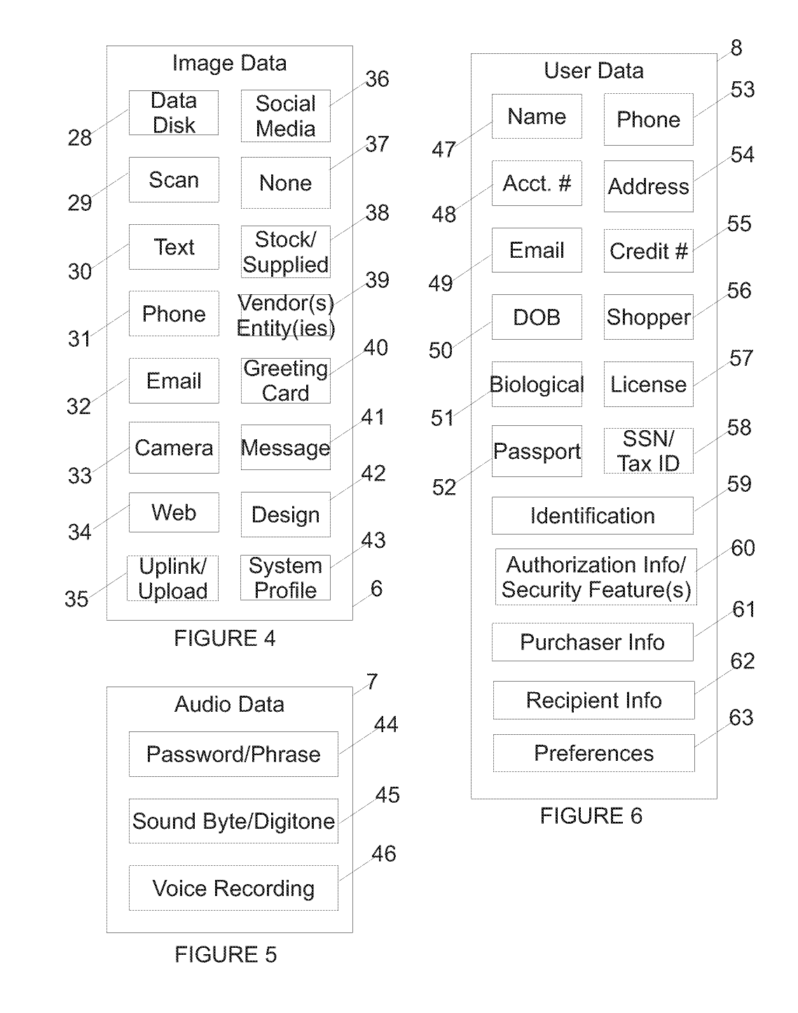

Turning to FIG. 4, image data 6, provided as part of customer input 4 may be provided to a system kiosk in a variety of ways. One or more images 28 contained on a data disk (e.g., images stored on an SD/mini-SD card, images stored on a solid state drive, images stored on a USB flash drive, images stored on a compact disk (CD), images stored on a DVD, images stored on an external drive, or images stored on portable or mobile computing device drive) may be provided to the kiosk with respective receiving and reading means. Although not all of these means for receiving data disk images 28 is expressly shown in the drawings, it is anticipated that such means for receiving data disk images 28 may be employed to any system-integrated kiosk. For example, a CD/DVD read drive may be employed to a kiosk 3 to receive images stored on a CD/DVD. A USB port may be provided to the kiosk 3 to receive images stored on a portable flash drive. An SD/mini-SD card slot may be provided to a kiosk to receive images stored on a SD/mini-SD card. Means capable of receiving improved solid state devices and future improvements to memory storage devices and new protocols is anticipated.

Image data 6 may be provided to a kiosk 3, by a user 91, 92, by providing one or more scannable images 29 (e.g., a printed photograph, a letter or document containing text, a business card, a scannable digital image which may be electronically displayed on a mobile computing device 96 (e.g., phone/tablet/watch/gaming device screen), a printed check, a bar code (e.g., 1D, 2D, data matrix, or QR code), a graphic, printed matter, a photo ID, a badge, etc.) to scanning means 102 or other image capture device 116 provided to the system-integrated kiosk 3. Image data 6 may comprise one or more “text”-based images, such as images texted from a mobile device to a kiosk-indicated or generated number, images which may be selected from a user's mobile application, and images sent from a mobile device to a kiosk 3 via SMS/MMS-based and similar messaging protocols.

Image data 6 may comprise one or more mobile device-taken images (e.g., images taken with cell phone, tablet, gaming device, PDA, digital camera, or portable computer screen which may be displayed proximate kiosk camera/image capture means 116 or kiosk image scanning means 102, or transferred using system software application (i.e., “app”). Near field communication (NFC) protocols may be used in conjunction with a system app to display, edit, crop, filter, or modify an image spontaneously taken with a user's mobile device (or previously stored on a user's mobile device 96) on kiosk display means 109. In some instances, a PIN or system-account login password may be replaced or bolstered with a physical key or token such as a user's fingerprint which may be scanned, a user's iris which may be scanned, a user's palm that may be scanned, a user's driver's license which may be scanned, or an object of a user that may be optically scanned using scanning means 102 and then compared with an image of the physical key or token stored in the system database. Such an object of a user may comprise such things as a wedding band, a watch, a favorite charm, a wallet photo, or other item normally carried on the user which would not normally constitute a measure of security.

Image data 6 may comprise one or more images provided via email. An emailed image 32 may be, for example, an image from a mobile device 96 such as a cell phone, smart phone, tablet, PDA, gaming device, or computer which is emailed to a kiosk-indicated or otherwise generated email address. Other images 32 delivered via internet email transmission protocol, multipart/mime message, base64 encoded image in a data:url, HTML-formatted SMTP message, or email attachment may form all or portions of image data 6.

Image data 6 may comprise one or more camera images 33, such as images which may be taken using kiosk camera/image capture means 116. Images may be captured using one or more of: flash, illumination, thermal, infrared, night vision, or other low light sensitive means or capabilities for capturing images of a kiosk user's face and/or surroundings, for example, even during night use in outdoor locations. In some embodiments, camera/Image capture means 116 may comprise a digicam, a webcam, a digital camera, a video camera, a CCD or CMOS sensor chip-comprising imaging device, an optic such as a fiber optic, CCTV-compatible camera, camcorder, and the like, without limitation.

Image data 6 may comprise one or more web images 34, or images which may be selected from the web. The web images 34 may be provided and listed by the kiosk 3 or may be selected by a user 91, 92 on their mobile device 96 via a system-integrated software application. Web image 34 may comprise an image from an internet profile (e.g., Facebook, Meetup, Instagram, Flicker, LinkedIn), a fair use/Creative Commons digital image library, or selected via the internet using a kiosk browser 131 which may be powered by an external search engine or website (e.g., Google, Yahoo, etc.).

Moreover, image data 6 may be provided by a user 91, 92 of a kiosk 3 using one or more kiosk-provided cables, connectors, universal connectors, and the like, or wirelessly, by using wireless-enabled technologies. Such uploaded/uplinked images 35 may be provided from a mobile device 96 (e.g., phone, tablet, PDA, gaming device console, mobile computer, or laptop) using hardwire or wireless means. For example, in some embodiments, such images 35 may be uploaded to a system kiosk 5 via cable (e.g., serial cable, FireWire, USB cable, Micro USB cable, IEEE 1394/1394a/1394b/1394c interface, i.LINK/Lynx interface), or a more preferred wireless technology (e.g., Wi-Fi/IEEE 802.11, wireless LAN/WAN, cellular data service, wireless sensor/network, short-range wireless communications, infrared communication, Bluetooth/IEEE standard 802.15.1/EDR/LS, Link Management Protocol/LMP, Audio/Video Remote Control Profile/AVRCP, Logical Link Control and Adaption Protocol/L2CAP/ER™/SM streaming mode, Service Directory Protocol/SDP, Radio Frequency Communications/RFCOMM, Bluetooth Network Encapsulation Protocol/BNEP, Audio/Video Control Transport Protocol/AVCTP, Audio/Video Distribution Transport Protocol/AVDTP, Telephony Control Protocol/TCS, Point-to-Point Protocol/PPP, TCP/IP/UDP, Object Exchange Protocol/OBEX, Wireless Application Environment/Wireless Application Protocol—WAE/WAP), PixDrop™ application or other multimedia Messaging Service/MMS).

As previously discussed one or more social media images 36 (e.g., images which may be selected from a personal/shared/friend internet profile such as Facebook) may be uploaded to the kiosk 5 using a system app loaded to a user's 91 mobile device 96. One or more social media images 36 may be selected from a user's 91 or user's friend's 92 social media profile by accessing the profile via a system kiosk 3. Preferably, a user 91, 92 may “link” their account to system software by downloading an application via the internet/cellular provider network 118, App Store, or system website 127. In this regard, social media images 36 of a user 91 or user's friend 92 may be more easily displayed on and utilized by a system kiosk 3 seamlessly without unnecessary interruption or external browsing. Social media images 36 may comprise digital images stored on external web-based storage means, personal image storage websites (e.g., Flicker, Picasa, Instagram), social networks and social network services, professional networks (e.g., LinkedIn), and/or personal storage drives such as cloud drives (e.g., iCloud). For example, a user may input or otherwise suggest an image to a system kiosk 3 via a social networking application (e.g., using a Twitter application, by sending a desired photo URL, such as an Instagram photo URL to a system-integrated kiosk-specific Twitter address (e.g., “@GoCards31278”).

A system kiosk 3 may provide a user with an option to select “no image”. In other words, image data 6 may include information indicating that a user 91, 92 of a system kiosk 3 may not wish to provide any image data 6. Such a preference may be determined from the user's pre-set preferences 63.

Image data may include one or more stock or supplied images 38 which are loaded to or otherwise accessed by the kiosk via the system website 127. For example, stock or supplied images 38 may include an image selected from the kiosk's searchable onboard database, a kiosk hard drive, the system website 127, system database 129, system server 128, entity database 137, entity server 136, or other external server 125 or database 135.

Image data may comprise image information 39 relating to one or more vendors, including the system's own brand and trade dress. Such vendor images 39 may include, for instance, logo, text, indicia, brand, trade dress, trademark, or graphic information which represents one or more particular participating vendor/entities. Vendor images 39 and digital information related thereto will be further appreciated from the figures of the instant application. Image data 6 may comprise one or more images 40 which are to be provided to a greeting card dispensed by a system kiosk 3. In preferred embodiments, the greeting card image data 40 is provided in a form which is compatible with a card holder such as those conventionally provided with a typical gift card. Greeting card image data may comprise any image which is obtained through the use of any means discussed herein, including kiosk-provided cameras 116, image scanners 102, etc.

Image data 6 may comprise message data 41 relating to a desired message output 25. Message data 41 may comprise, for instance, text/alpha-numeric/character-based/symbol inputs regarding one or more desired messages to be printed by the kiosk 3. In particular, message data 41 may be placed on a card 19, or greeting card, fortune, ticket (e.g., lotto ticket), receipt, or other article produced by the kiosk 3 for a user 91, 92. Message data 41 may be electronically sent to users of the system via the system website, cellular network, third party website (e.g., social network/social media website), and/or a system-based application such as a mobile app. Message data 41 may comprise, without limitation, one or more portions of a phrase, quote, paragraph, passage, greeting, or tiding. Message data 41 may comprise certain user data 8, for instance recipient or purchaser name information. Image data 6 may comprise design image data 42 which may comprise one or more portions of a pattern, a color, a texture, a sheen, a gradient, a background, a puzzle, a quiz or riddle, a visual game, word art, a pun, a brainteaser, a stereoscopic image, a 3D image, or a holographic image, without limitation. Image data 6 may comprise system profile image data 43 such as one or more images instantaneously uploaded or previously uploaded to the system website from a user mobile device 96, computer, or from an earlier kiosk 3 transaction, etc. System profile image data 43 may refer to any data stored on the system server 128, system website 128, system database 129, user's system profile or account, etc.

Turning now to FIG. 5, audio data 7 may comprise information regarding one or more passwords or pass-phrases 44 which may be spoken or otherwise verbally communicated to a kiosk and received and interpreted by audio input means 103. Password/passphrase 44 may comprise a repetition of a phrase or portion of a phrase delivered to a user's voicemail, email account, phone, or system account in either visual form or acoustic form, and/or various combinations thereof. Password/passphrase 44 may be or may comprise a playback of a file containing a sound recording, or a live recording. In some embodiments password/passphrase 44 may be uploaded or transferred from data storage means e.g., a data storage disk, solid state storage device, or mobile device hard drive, without limitation. Audio data 7 may include one or more sound-bites, sound clips, audible messages, or digitones 45 which may be of human or machine origin. They may include one or more voice recordings 46 made by a user 91, 92 of the system or third party. In some embodiments, audio data 7 may comprise playback audio from a digital device. Audio data may be communicated between the system server(s) 128, system kiosks 3, and user devices 95, 96 via the internet 118 or other communication network protocol known in the art (e.g., cellular network). Audio data 7 may be conveyed through various instruments known or commonly used in the art including, but not limited to voicemail and email, as well as MMS protocols when sound is converted to a displayable in a visual format (e.g., waveform).

Turning now to FIG. 6, user data 8 which may be provided to a system kiosk 3 or contained within a user profile 130, may comprise information about a user 91, 92 of the system. User data 8 may comprise, without limitation, one or more of the following pieces of information: name information 47 (e.g., pertaining to last name, first name, middle name, middle initial, maiden name, given/family name, nickname, userID, screen name, account name, etc.), account number information 48 (e.g., information relating to a user's system website account number, information relating to a user's credit card account number(s), information relating to a user's banking account number(s), information relating to a user's financial institution account number(s), information relating to a user's member/club account number(s) (e.g., AARP account number, AAA account number, Entertainment Club number, Costco/Sam's/BJ's discount club number, USHPA club account number, ClubCard account number, Rotary Club account number, Club Penguin membership number, Groupon account number, VIP Club membership account number, Diners Club International account number, Realtor membership number, etc.), information relating to a user's insurance company account number(s) (e.g., HIPPA-compliant Blue Cross/Blue Shield account number, Select Health account number, Aetna account number), information relating to a user's payment company account number(s) (e.g., PayPal account number), information relating to a user's shopping account number(s) (e.g., Amazon.com account number, Microsoft Xbox Live Gold Membership card, GNC Gold card membership, eBay account number), information relating to student ID account(s) information, information relating to a user's alumni/fraternal association membership number(s), information relating to one or more customer loyalty account numbers (e.g., Subway Club card, My Starbucks Rewards card), information relating to one or more shopper's cards of a user (e.g., Smiths's card account, Kroger card account, Safeway card account, Fresh Market card account, Whole Foods card account, Pep Boys rewards account, Jiffy Lube Fleet card account), or other account information, user email address(s) 49 or information relating to a user's email address(es) such as hosting organization (e.g., Google, Yahoo, Facebook, AOL, Microsoft, Corporation, company, organization, workplace), birth date information 50 of a user (e.g., decade, year, month, day, or time of birth, age, or age verification information (e.g., over 18? over 21?)), biological or biometric information 51 pertaining to a user (e.g., fingerprint information, retinal/iris scan information, facial features information, tattoo information, recognizable biological information, B.P.A.C.-compatible biometric information/data, information regarding voice or speech patterns, vein pattern information), user passport information 52 (e.g., passport number, issuing country, nationality, issue date), information regarding a user's phone number (e.g., phone number, area code, last four digits, country code, cellular service provider), address information 54 (e.g., regarding a user's physical address, mailing address, home address, work address, current address, former address(es), zip code, street number, city, state, town, country, address of the nearest kiosk in relation to a user's place of work, address of the nearest kiosk in relation to a user's place of residence), user credit card information (e.g., types held, entire credit card number, last four digits of account number, security code, pin, electronic purse information), information 56 regarding a user's frequent shopper or loyalty programs (e.g., frequent flier miles programs and account values thereof, grocery cards and account values thereof, gas/fuel rewards programs and account values thereof, cash-back awards programs and account values thereof, incentive rewards programs and account values thereof, frequent diner awards account information and account values thereof), information 57 regarding a user's license (e.g., drivers license number, issuing state/country, professional licenses information, certification information), user taxpayer information (e.g., social security number, resident ID number, birth certificate number, tax ID number), user identification information 59 (e.g., information listed on a user's identification card, residency card, alien card, voter registration card, healthcare card, military ID, student ID, or information pertaining to a user's online profile ID or alias, demographic information, race information, donor information), user authorization/authentication information 60 (e.g., security feature(s), crypto algorithm such as triple DES or RSA, password(s), passphrase(s), digital certificate(s), digital signature(s), public key infrastructure (PKI), encryption key(s), fob information, PIN(s), site-key(s), RFID/wireless keycard information, FIPS 201-compliant device information, Smart Card Web Server (SCWS) information, SIM card data, non-repudiation data, data hash information, data encryption/decryption means, trusted third party (TTP) information), purchaser information 61, recipient information 62, information regarding a user's preferences 63 (e.g., user's native language, current location, favorites 140, friends/relatives 145, user history 146 management preferences), and/or other information about a user of the system, without limitation. Redemption data 64 may comprise information pertaining to a redemption option purchased by or received by a user. The redemption option may be for the individual, group, or entity who wishes to redeem the redemption option personally, or the redemption option may be for another individual, group, or entity. The redemption data 64 may pertain to a particular vendor or entity 65, preferably, a vendor or entity 65 which participates in the system and which may support various hardware, software, and communication protocols necessary to successfully implement the system and provide a seamless experience for a user. Where used herein, a vendor or entity 65 may comprise, without limitation, an individual, a user, an organization, a corporation, a wholesaler, a dealer, an online website, etc, as shown in FIG. 11. More specifically, and without limitation, a vendor or entity may comprise one or more of the following: a gym, a fitness club, a train, a shuttle, public transportation, a cab, a financial assistance institution, a casino, a salon, a parlor, a barber, a bank, a lender, an online payment system, an arts and crafts store, a fair/festival, a club, an organization, a mortuary, an arena, a stadium, a gas station, an amusement park, a theatre, a housing management company, a landlord, a government agency, a money transfer company, a service provider, a credit card company, a financial institution, a racetrack, a resort, a hotel, a lodging facility, a pharmacy, a wedding planning entity, a store, a retail shop, a pawn shop, a restaurant, an entertainment company, a ski resort, an airline, a medical facility, a cellular provider, a website, an auction house, an online auction, a lottery, a betting pool, a health provider, a franchise, a chain, an airport, a rental agency, a school, a tuition department, a library, a repair shop, a contractor, an automotive dealership, a florist, a collection agency, a media sales company, a media rental company, a gaming institution, a utility company, a mall, an outlet, a moving company, an escrow service, or an entity offering private lessons. Where used herein, purchase data 9 may comprise information which is similar to information pertaining to redemption data 64. Redemption data 64 may comprise amount information 66, such as a value of purchased funds or credits, goods, services, or offers. The amount information 66 may be in a native value unit (e.g., USD, points, miles, rewards points, customer visits, etc.), or the amount information 66 may be in a converted value form, such as an arbitrary system-based credit unit (e.g., “Go-Bucks”). Various components (e.g., 3, 95, 96,100, 108, 127, 128, 129, 147) of the system may comprise software which makes such conversions in an expedient manner. Conversion multiplier values may be provided by various vendors or entities 65 and stored in the system database 120. It is foreseen that each vendor or entity may provide multiple conversion multiplier values—each pertaining to different products, services, or offerings provided by the vendor or entity. In some instances, amount information 66 may be presented in a unit that is easily identifiable, such as in terms of a local monetary value as will be apparent from the appended figures.

Redemption data 64 may be associated with a redemption option such as a pass 67 (e.g., a toll lane access pass, a VIP access pass, a ski pass, a ride-share pass, a rail pass, a travel card-based pass, an entry access pass, an admission pass, an amusement park pass, an entertainment venue pass, a transit pass, a season ticket pass, etc.) The redemption data 64 may comprise information regarding one or more valid use dates 68 (e.g., a valid timeframe, a valid hour, a valid day, a valid month, a valid year, a valid time, a valid date range, etc.). The redemption data 64 may comprise information pertaining to a date of issue of a redemption option (e.g., day issued, month issued, year issued, season issued, time issued, etc.).

The redemption data 64 may comprise information regarding one or more expiration dates 70 (e.g., day of expiration, month of expiration, year of expiration, time of expiration, etc.). Partition information 71 may be associated with a redemption option, for example, to accommodate multiple uses, specific uses, or a plurality of different redemptions for a single vendor or entity 65 or for a plurality of different redemptions for different vendors or entities 65. Partition information 70 may form a portion of physical storage in reference to a physical component of the system (e.g., a card 19 or chip 86 inside card 19), but may preferably comprise pointer information to a larger data matrix or array storing a plurality of redemption options within a system database 129. Partition information 71 may, for example, be used to assign, categorize, and/or organize multiple past purchases, transactions, unused redemptions, newly added redemption options, histories, and incoming user funds or credits, etc. to a single user account profile 130 which may be affiliated with a physical system-integrated card 19 or system account.

Redemption data 64 may comprise type information 72 associated with one or more types of redemption options discussed herein and shown in FIG. 9. Redemption data 64 may comprise information regarding one or more event details 73, such as details pertaining to a particular venue/location 2 (e.g., arena, stadium, racecourse, concert hall, fairgrounds,), a particular event time, a particular event date, promotions relating to a particular event, performer information, team details, game details, performance information, race information, fairgrounds location information, etc. Supplemental data 74 such as registration details, restrictions, vendor options, rules, terms and conditions, terms of use, privacy information, waivers of liability, etc. may be included in redemption information. It should be understood that while particular examples are given in this detailed description for illustrative purposes, redemption data 64 and/or purchase data 9 may include any conceivable tangible purchasable product, good, or service, including purchasable offerings, rewards points, loyalty points, frequent shopper points, miles, deals, incentives, coupons, tickets, redemption codes, promotions, funds, cryptocurrencies, tradable assets, holdings, stocks, credits, vendor-accepted tokens/chips, store credit, and the like, without limitation. Types 72 of redeemable options which may be purchased, saved, distributed, transferred, and sent using the system may comprise ticket-based redemptions 75. Tickets 75 may include, for instance, tickets to movies, tickets to plays, tickets to sporting events, tickets to productions, tickets to concerts, tickets to operas, tickets to a gaming facility or arcade, tickets to a club, ski lift tickets (including direct-to-lift tickets), bowl/skate tickets, admission tickets, integrated tickets, smart card tickets, a ticket to a race, airline tickets, or proof of prepaid parking tickets. Types 72 of redeemable options may include prepaid minutes 76, such as cell phone minutes, calling card minutes, massage minutes, shop time minutes, service minutes (e.g., legal services, consulting services, computer networking services), labor minutes, etc. Types 72 of redeemable options which may be purchased, saved, distributed, transferred, and sent using the system may comprise information 81 regarding stocks, mutual funds, or other tradable asset information 81. Such stock information 81 may comprise account balances, share prices, market identifier codes, company names, international securities identifying numbers, ticker/stock symbols, National/International securities identifying numbers, CUSIPs, certificates of deposits, withdrawal certificates, syndicated loan information, tradable asset information, IPO information, wealth management account numbers, exchange traded fund (ETF) information, and the like, without limitation. Moreover, lottery or bet-based information 82 such as lottery tickets, wagers, voucher information, scratch off, betting pool receipts, proofs of bets, wager receipt information, etc. may be purchased or redeemed by users of the system using system components 3, 127, 147. Moreover, terms and conditions 83, such as restrictions, terms of use, waivers of liability, indemnifications, and privacy terms may be associated with certain types of redeemable options.

System kiosks 3 may be configured to produce physical deliverables (e.g. cards 19) which comprise image information 77 (e.g., indicia, graphics, designs, pictures, text, photos, overlays, holograms, etchings, embossments, logos, trademarks, printed matter, patterns, lines, characters, etc.), points information 78 (e.g., frequent shopper points, frequent flier miles, member/membership points, customer rewards points, frequent diner credit points, loyalty points, etc.), and/or one or more barcodes 79 (e.g., one or more 1D barcodes, 2D barcodes, universal product (UPC) codes, ISO/IEC 15416-compliant markings, ISO/IEC 15426-2 compliant markings, ISO/IEC 15415-compliant markings, ISO/IEC TR 29158-compliant markings, etc.).

System kiosks 3 may be configured to provide similar electronic deliverables to a user via a system website 127 or system application 147 (e.g., a mobile app). These components may include similar information as card 19, and may include audio information 80 (e.g., one or more voice-recordings, sound bites, digitones, voice recognition tokens, audio files, sound wave files, etc.). The audio information may comprise any type of sound wave, including sound waves of various frequencies.

Cards 19 produced by kiosks 3 may comprise data storage means 84, such as a solid state device 85, a chip 86 (e.g., an integrated circuit, a microprocessor, a security authentication device, a single sign-on SSO device, an EMV chip, an ISO/IEC 7816 device, a contactless “smart” ISO/IEC 14443-compliant device, an inductor-comprising device, a straight memory 1 k-1 Mbit Flash EEPROM I2C/SPI device, a protected/segmented memory 3 k to 64 kbit EEPROM device, stored value memory, an 8-bit Symmetric key/file-based 8-144 kB EEPROM device, an 8/16/32 bit public key dynamic 8 k-1 MB EEPROM with math coprocessor, a 125 kHz proximity read-only device, a 13.56 MHz ISO 14443 0.5-8 kB read/write device, a MiFare protocol device, a proprietary protocol device, an ultrahigh frequency gen 1 or 2 device, a semiconductor, or the like, without limitation.

Cards 19 produced by kiosks 3 may comprise magnetic information storage means 87 (e.g., high-coercivity HiCo means or low-coercivity—LoCo means). Cards 19 produced by kiosks 3 may comprise an RFID device 88 (e.g., an antenna, an electromagnetic field device, a tag, a transponder, a frequency modulating/de-modulating device, a passive reader active tag device, an active reader tag device, a battery assisted tag (BAT) device, electronic product code EPC information, a mobile computing communication device, a smart sticker, a virtual badge device, or a wireless tracking device). Alpha-numeric information 89 (e.g., text, characters, numbers, letters, printed indicia, embossed indicia, cryptotext) may be provided to a card 19 produced by a system kiosk 3. Metadata 90 (e.g., use date, use time, use location, place of use information, descriptive information, structural information, copyright/IP information, syntax, hierarchical information, linear/planar schemata, hypermapping data, granularity data, standardization information, cataloging information, technical information, business information, process information, cloud access information) associated with card 19 use may be tracked by one or more entity payment systems 100. Metadata 90 may be tracked and stored on a system database 128. Various components of the system, such as system kiosks 3, the system website 127, and applications 147 associated with the system, as well as other third-party components 153, 156, 159 may track card 19 and/or user 91, 92 activity in general. FIGS. 76 and 80-82 some possible uses of metadata 90, for example, in creating detailed user histories 146 or user profiling for use by marketing firms 94.

The system and various components thereof may comprise integrated social media websites 93, including, but not limited to personal websites, networking websites, business/professional development websites (e.g., LinkedIn), image sharing websites (e.g., Picasa, Instagram, Shutterfly), dating websites (e.g., Match, eHarmony), a group/club website (e.g., Yahoo groups), meeting place website (e.g., Meetup), social network service (e.g., Facebook, Twitter, YouTube). Users 91, 92 may choose to link their system account with their various social media profiles to provide seamless interactions and/or communications with friends or relatives 145 while using the system, while shopping, and/or while navigating for a particular product, good, or service 151 in real-time. It should be understood that the system itself may utilize various information pertaining to a user's third party social media interactions to provide target advertisements, and improve a user's overall experience while using the system. Users 91, 92 of the system may add or create new system-based friends, in particular, individuals who partake in frequent transactions with the users 91, 92. In some preferred embodiments, a user 91, 92 of the system may be able to readily identify one or more products, goods, services, or offers which are “liked” by a potential recipient. Moreover, a user 91, 92 of the system may be able to make purchasing decisions based on the popularity of one or more products, goods, services, or offers provided as a redemption option available for purchase. In this regard, a user may select redemption options based on the number of Facebook “likes” by friends 145, or system-based favorites 140 of other users or friends 145. Redemption options having a large number of “likes” or indications of being a “favorite” 140 may serve as recommendations, or “wish-lists”, which may assist a user with purchasing or gifting decisions.

One or more advertising firms, marketing solutions firms, and/or market research firms 94 may be integrated with the systems described herein, for example, via software and access to a system database 129. In this regard, data regarding user profiles 130, such as purchase and redemption histories 146 may be used to help vendors and/or entities 65 more efficiently market their products, goods, and/or services.

In some preferred embodiments, a user may access their system profile 130 (i.e., system “account”) using a computer 95, such as a CPU, a desktop computer, a laptop computer, a tablet, or other computing device. In some preferred embodiments, a user may access their profile 130 using a mobile computing device 96, such as a smart phone, a cell phone, flip phone, a tablet, a smart watch, a portable gaming device, a laptop, a voice-over IP (VOIP)-compatible device, a Maxwellian view optical system or other virtual retinal display device, a wearable computer, or a wearable computer provided with an optical head-mounted (OHMD) display (e.g., Google Glass device).

Information 121 pertaining to products, goods, services, promotions, offerings, funds, credits, points, and/or other conceivable saleable redemption options 151 may be accessed via a system kiosk 3, system website 127, or system application 147. The information 121 may be updated by accessing one or more entity databases 137 (e.g., data storage databases, data center databases, third party databases, third-party support service databases, entity supporting databases, third party online gift card exchange service databases) stored on one or more entity servers 136. Alternatively, the information 121 may be stored on one or more system databases 129, and updated through the system website 127. Even more alternatively, the information 121 may be updated via the firms 94 used by vendors and/or entities 65 to market redemption options 151. In preferred embodiments, at least the system database 129 contains the information 121, and is updated regularly to reflect the most up-to-date information regarding saleable redemption options 151.

One or more financial servers 122 and/or financial databases 138 (e.g., GE Capital Retail Bank (“GECRB”) databases, Discover Financial Services databases, American Express databases, Visa databases, US Bank databases, Co-op network databases, Cirrus databases, Star databases, JPMorgan Chase & Co. databases, Bank of America Corp. databases, The Goldman Sachs Group, Inc. databases, Capital One VentureOne(SM) Rewards Credit Card databases, Discover databases, housing credit card rewards points databases, etc.) which are affiliated with financial institutions may be integrated with the system and components thereof. Financial servers 122 may comprise, for instance, bank servers, credit card company servers, escrow service servers, online payment system servers (e.g., PayPal servers), acquiring bank servers, virtual private servers/farms/or mines (e.g., Bitcoin servers), depositary institution servers, credit union servers, trust company servers, mortgage loan servers, contractual institution servers, pension fund servers, investment institution servers, investment banking servers, underwriter servers, brokerage firm servers, and/or corporate servers, without limitation. In some aspects, funds or credits associated with purchases made through the system (e.g., via system kiosks 3, system website 127, or via system applications 147) may be deposited with the system's financial institution 163. Upon use of a redemption option at a particular entity, the system's financial institution 163 may make the vendor or entity whole (See FIGS. 12, 61, and 62).

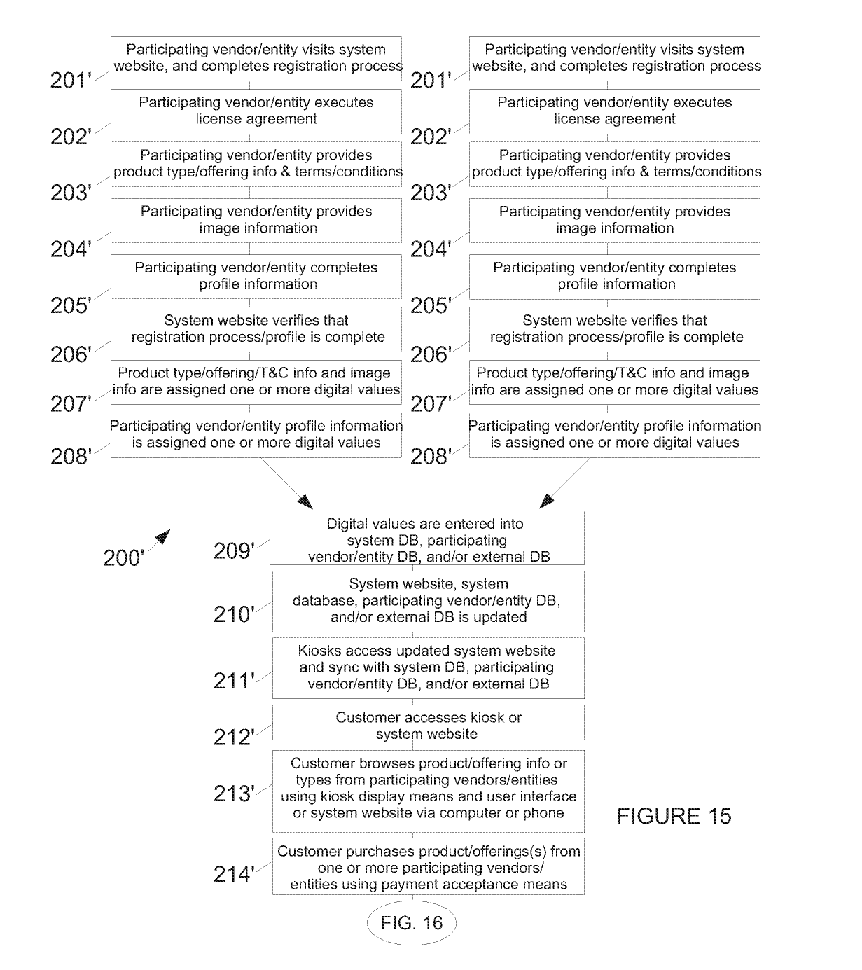

For example, a gift card may be purchased by a customer, using a system kiosk 3, system website 127, or system application 147. The funds or credits associated with the payment data 10 received by the customer may be deposited into an account associated with the system's financial institution. When the customer or end recipient of the gift card uses the gift card at a vendor or entity 65 to redeem a purchased option, the system may make a payment to the vendor or entity 65 via the system's financial institution. The payment made to the vendor or entity 65 may be in full, or in part, depending on certain pre-made contractual arrangements between the vendor or entity and the system. Such contractual arrangements may be made when the vendor or entity 65 opens an account or otherwise signs on with the system (see step 202′ of FIG. 15).

Kiosks 3 described herein may comprise a housing 124, such as a cabinet structure, a chassis, or frame which contains various components of the kiosk. Preferably, housing 124 is metal or otherwise of a form and/or nature that is secure and protects various components of the kiosk 3 from damage, vandalism, theft, and the elements. Housing 124 may contain certain climate control devices to prevent moisture buildup and/or to control temperature within the kiosk. Such devices may comprise air conditioners, fans, dehumidifying apparatus, heating elements, and the like, without limitation. Housing 124 preferably has a top, bottom, front, back, and two side panels. The housing 124 may be formed from any materials suitable for its purpose, for example, molded fiberglass, plastic moldings, stamped sheet metal, and/or various combinations thereof, without limitation. However, it should be understood that kiosk housings 124 may be constructed from a variety of other suitable materials and with a variety of other suitable manufacturing techniques.

One or more external servers 125 (e.g., data storage servers, data center servers, third party database servers, third party corporation servers, third-party application servers, third-party support services, entity supporting servers, third party online gift card exchange service servers, cryptocurrency exchange client servers, etc.) may be integrated with the system to facilitate certain tasks, executions, functions, and transactions. For example, the system may incorporate existing web-based services for cashing frequent flyer miles. In another example, the system may incorporate and/or communicate with certain online gift card/eGift certificate exchanges. In yet another example, the system may connect or otherwise communicate with cryptographic exchange clients to facilitate digital currency transactions between users and certain components 3, 127, 147 of the system. Third party application software 148, encryption/decryption keys, etc. may be integrated with system software 147 as necessary to integrate such services and/or access the external servers 125. One or more external databases 135, such as entity-affiliated databases, gift card information databases, Retail Gift Card Association RGCA databases, databases used for storing rewards points information, and SMS auto-responder databases may be affiliated with external servers 125, without limitation.

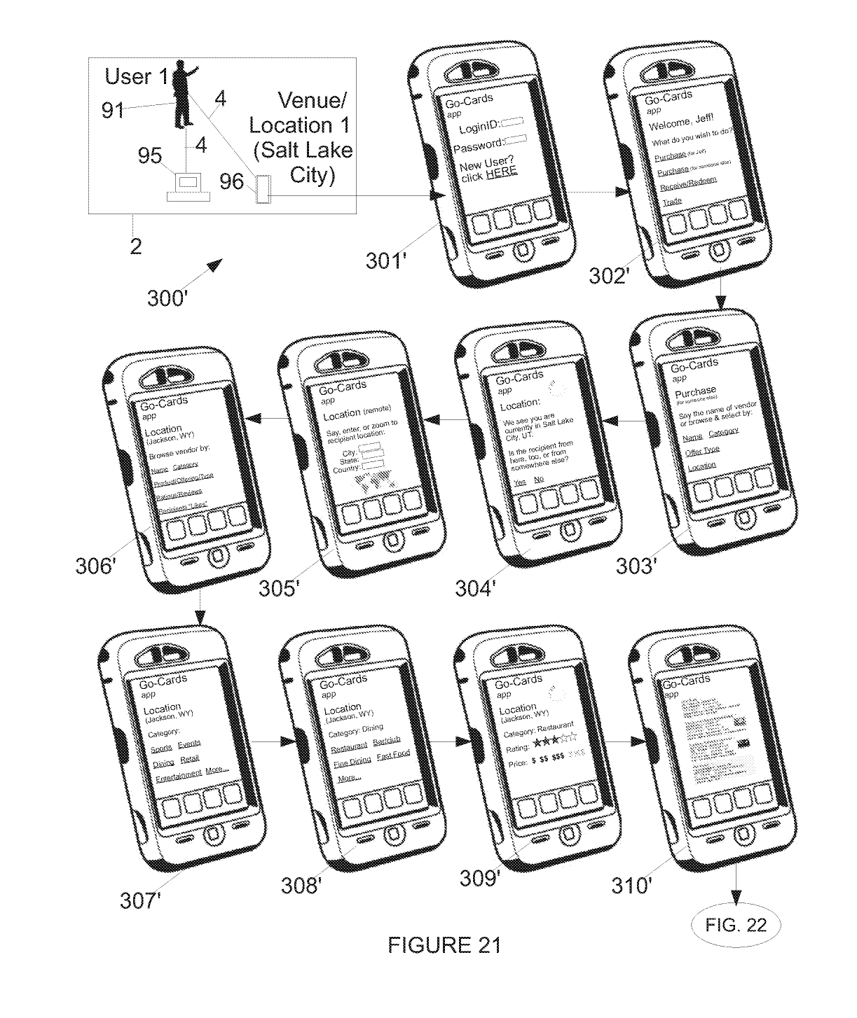

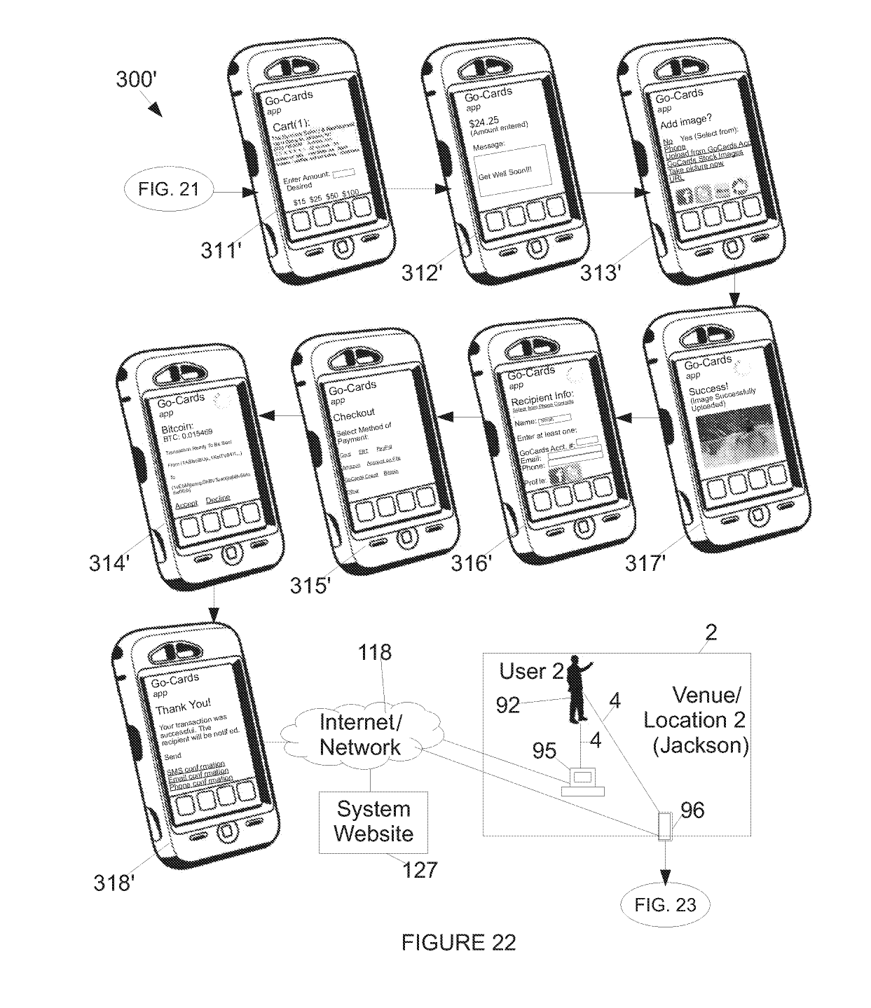

When visiting a system kiosk 3, system website 127, or system-based application 147 such as a mobile app, a user 91, 92 may be prompted to login to their system profile 130 via a sign-on or login page 126 (see step 301′ in FIG. 21, and FIG. 27). One or more browsers 131 may be used to support the presentation of certain redemption options provided by the system. Once selected, a redemption option may be added to a cart 133. Items within a user's cart 133 may be purchased via a secure check-out page 132 by the user, or by another user. Items within a user's cart 133 may be purchased by selecting a “request gift” icon within the secure check-out page 132. As shown in the upper right portion of FIG. 65b, activation of a “request gift” icon may prompt another user (e.g., such as a friend 145 or relative) to send funds or credits to the system so that the item may be purchased or otherwise redeemed by the requesting party. For example, a second user 92 may access a system kiosk 3 or system application 147 from their mobile device 96. The second user 92 may, using the system browser 131, peruse a variety of types 72 of redemption options. The second user 92 may then select a redemption option, proceed to the check-out page 132, and then select a “request gift” icon or the like. The second user may be prompted for information 4 pertaining to who 91 the gift is to be sent from or otherwise purchased by (e.g., the sender's 91 name 47, email address 49, phone number 53, system account number 48, etc.). The requested sender, or first user 91 may receive a message from their mobile device 96 requesting a payment be made for the particular redemption option selected by the second user 92. The first user 91 may approve or decline the transaction, for example, by replying to an SMS/MMS-based message, or via a prompt provided to the first user 91 through a system application 147 installed on the first user's 91 mobile device 96. Other uses of browser 131 will be readily apparent from the appended figures. For example, browser 131 may piggy back off of certain existing architectures and infrastructures such as third-party sites (e.g., Hotels.com, Priceline.com, Amazon.com, Groupon.com, SkiSite.com) to facilitate information 121 transfer regarding particular products, goods, or services 151.

Browser 131 may comprise any browser, for example, an Avant browser, a Google-based browser (e.g., Chrome), a Mozilla Firefox-based browser, an Opera-based browser, a Maxthon-based browser, an Internet Explorer-based browser, or a Safari-based browser, without limitation. Browser 131 may comprise a user homepage 139, which may be personalized with one or more favorites 140. Favorites 140 may include redemption options which are “liked” or otherwise preferred by the user or a friend 145 of a user. Favorites may be system-based favorites, for instance, shown with a heart icon to differentiate from third-party (e.g., Facebook) “likes”. The user homepage 139 and/or browser 131 may allow a user to add all or a select number of friends 145 from third-party social media networks. The user homepage 139 and/or browser 131 may allow a user to add all or a select number of system-based friends 145 which are users of the system. Depending on the user's set preferences 63, certain friend 145 information and/or “likes” or favorites 140 of certain friends 145 may be hidden. The user may be provided with an option in preferences 63 page to “show all likes”, wherein a total number of third party “likes” or system user favorites 140 may be shown adjacent redemption options. In this regard, a user may be able to better make purchasing decisions based on the popularity of a redemption item in general. In yet further embodiments, depending on the user's set preferences 63, all friend 145 information and/or “likes” or system favorites 140 of all friends 145 may be hidden. If such an option is selected, then the user's third-party “likes” or favorites 140 of redemption options provided by the system may be shown, and/or only the user's third-party “likes” or favorites 140 of redemption options provided by the system may be shown.

Browser 131 may include one or more drop-down fields, touchable icons, drag and drop interactions (e.g., wherein a user may drag desired redemption options to a “cart” icon 133 before checking out on a checkout page 132, etc). Browser 131 may configured to enable a user to sort redemption options by popularity, by favorites 140, by the number of third party application 148 “likes”, or ratings (e.g., on a 1-5 star rating), or the browser may be configured to allow a user to see all redemption options according to user preferences 63. In some embodiments, the placement of redemption options within browser 131 may be based on a user's social network interactions. For example, a user may associate a number of redemption options with a particular friend 145. This may be accomplished by using information pertaining to the friend's third party application “likes” obtained from a social media site 93. A user 91 may browse redemption options by selecting a particular friend 145, wherein a browser 131 page may display all types 72 of redemption options which the particular friend 145 may likely appreciate, thereby facilitating gifting options. System kiosks 3, cards 19 produced by system kiosks 3, as well as mobile applications 147 supported on user mobile devices 96, may be configured to communicate information using near field (NFC) communication protocols 134 and/or NFC technologies. For example, cards 19 may be read by reader means 110 provided to system kiosks 3. Mobile devices 96 may be read by reader means 110 provided to system kiosks 3. For example, digital wallets stored on a user's mobile device 96 may be used, withdrawn from, or credited based on user input 4 selections during kiosk 3 interactions. Moreover, system cards 19 and/or mobile devices 96 supporting a system application 147 may interact with NFC-compatible payment receiving means 100 provided to various vendors and entities 65 and websites thereof. Such “tap-and-go” functionalities may improve customer experiences when using the system.

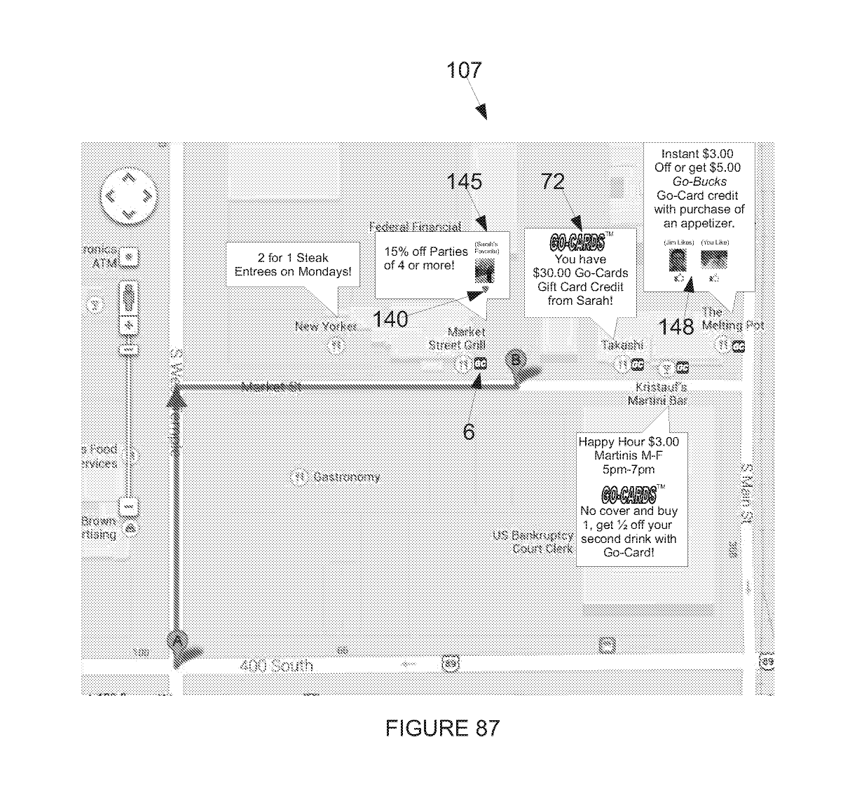

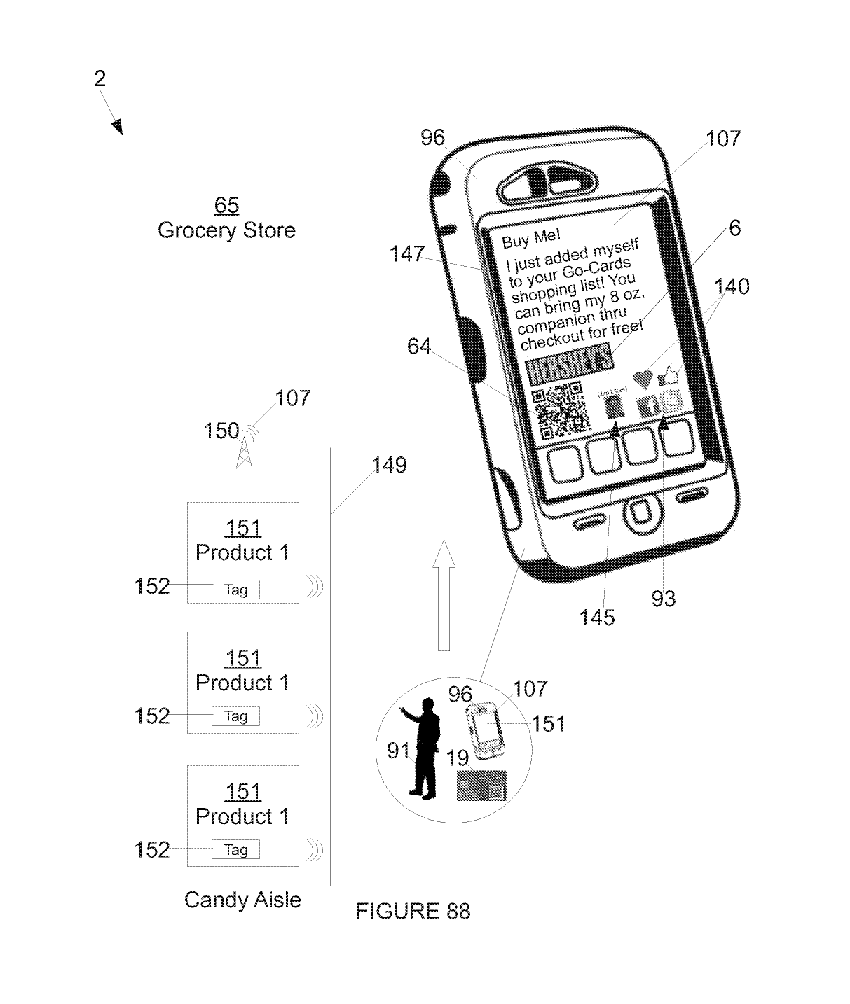

Throughout various interactions between a user and a system kiosk 3, system website 127, and/or system application, a number of updates 142 may be made within the system and/or external systems. Updates 142 may comprise, for instance, and without limitation, account updates (e.g., system account updates, third party account updates, user financial account updates, user loyalty account updates, user frequent shopper account updates, user frequent flyer miles account updates, user hotel stay points accounts updates, user shopper rewards accounts updates, user frequent diner points account updates, etc.), system updates, system database 129 updates, system website 127 updates, system server 128 updates, payment data 10 updates, purchase data 9 updates, redemption data 64 updates, user data 8 updates, audio data 7 updates, image data 6 updates, etc.). Such updates 142 may occur during user interactions with a entity 65, for instance, upon checkout, payment, or redemptions using system components 19, 147, including interactions at brick-and-mortar establishments and online establishments (e.g., a entity website). Updates 142 may happen automatically, or upon distinct user inputs 4. For example, updates 142 may occur automatically when a user is shopping in a particular venue or location 2, or when a user is in a particular location within a structure of a venue or entity 65. This may be appreciated from FIGS. 65a, 65b, 77b, 77c, 78, 87, 88, 89e, 90b, and 90c.

Location data 143 may be utilized within the system. For example, location data may be sent to a user's mobile device 96, shown on display means 109 of a system kiosk 3, displayed on the system website 127, or displayed on a entity's 65 website. Location data 143 may include, without limitation, information regarding a location of products, goods, promotions, or offerings, sales location information, entity store layout information, information regarding product placement within a particular venue/location 65, information regarding a entity's geographic locations, e.g., as shown on a map, etc. It will be appreciated that location data 143 may comprise any information relating to location of a good or service, as well as a location of a user, a location of use of a card 19, a location of a system kiosk, a location of a particular vendor or entity, a particular location within a venue/location 2, and the like, without limitation. In preferred embodiments, location data 143 may be used to track a user's historical transactions and interactions with various components of the system. Location data 143, for instance, may comprise information regarding a user's shopping habits within a particular venue or location 2 or within a structure of a vendor or entity 65. Location data 143 may comprise information pertaining to a location where a user uses a system application 147 (e.g., on their mobile device 96). Location data 143 may relate to a particular point of sale visited by a user 91, or a permanent or current location of a user friend 145. Location data 143 may relate to a real-time position of a user's mobile device 96 supporting a system application 147, or location data 143 may relate to a real-time position of a card 19 held by the user (e.g., a kiosk-produced card).

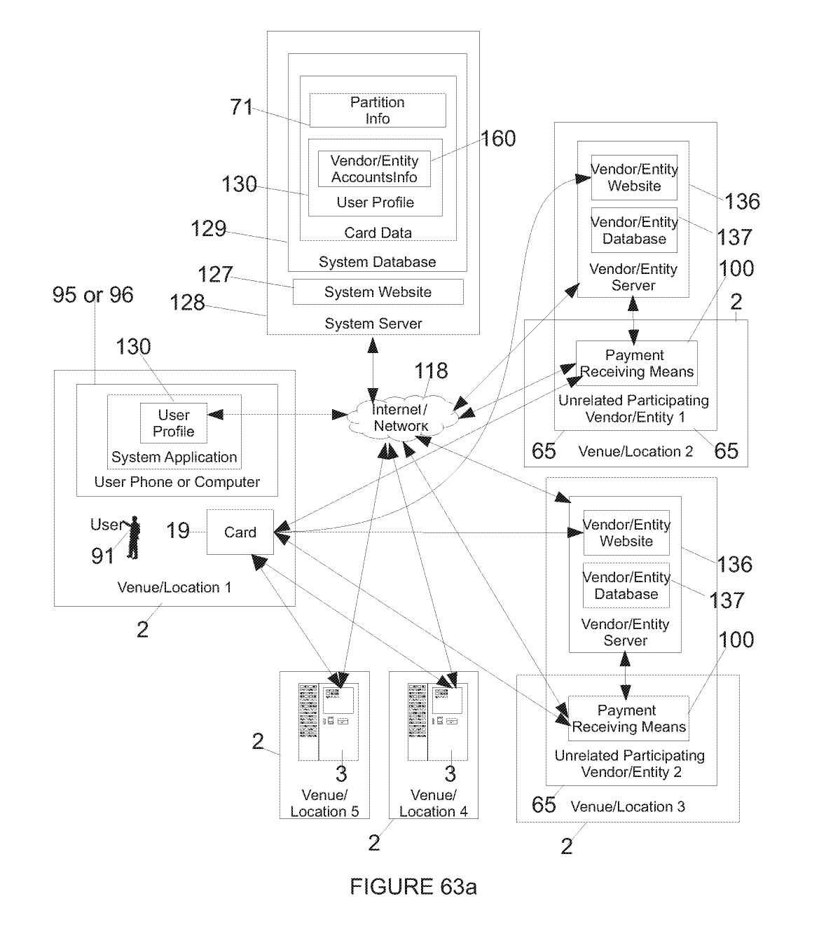

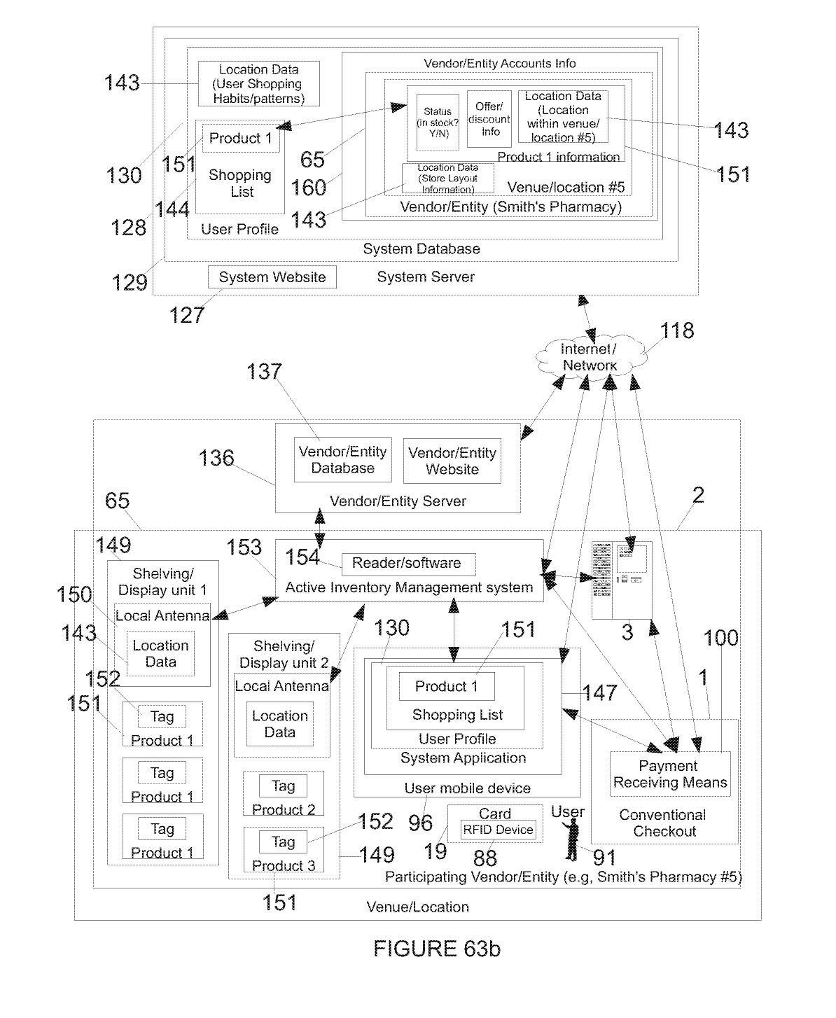

FIG. 63A shows that the system database may be refreshed with digital coupons, deals, and promotions from participating vendors periodically (e.g., weekly). When the digital coupons, deals, and/or promotions expire, such data connected to or with the card may be automatically removed by the system.

FIG. 63B shows that a system-integrated app may be used by user while shopping at any participating vendor. A participating vendor's location may comprise tags (e.g., RFID, QR code) in or on products, product packaging, or shelves/hardware storing or displaying products. The system-integrated app may link to a user's shopping list information on the user's system profile and the vendor's active inventory management system to notify the user of in-stock status or direct the user to one or more particular products on the user's shopping list within the entity's venue/location, or track the user's shopping patterns within the venue/location.

Some embodiments may utilize a credit-based system, e.g., where both cryptocurrency and other forms of traditional currency may be used to purchase system-recognized credits which may then be divided, allocated, and subsequently spent at participating vendors in any fashion. When the system-recognized credits (e.g., “Go-Bucks” or other conceivable fanciful name for the system-based credits) are presented to a participating vendor (whether selected at an online check-out or presented to a checkout, or cash register at the point-of-sale), the vendor's payment system may send the requested amount due to the system servers. The system may then access its system database to verify the user's account information. If there are sufficient system-recognized credits in the user's system account, then the system may make a direct deposit/payment to the vendor for an equivalent amount of electronic funds stored at the system's closest financial institution. Thereafter, the user's account information may be updated to reflect the loss of system-recognized credits. Users of the system described herein may utilize funds or credits purchased or received through a system kiosk 3 via a kiosk-produced card 19, which may be customized in nature. Users of the system described herein may utilize funds or credits purchased or received through a system kiosk 3 by transferring information relating to the funds or credits to a mobile device 96, for example, a mobile device linked to the system network via a system application 147. Funds or credits may be transferred to a user's digital wallet stored on a mobile device 96.

Once funds or credits have been transferred to a mobile device 96, the consumer may utilize the value associated with the funds or credits for various types of mobile payment solutions. Such solutions may include, for instance, the purchasing of goods and/or services at a retailer by scanning the mobile device near a terminal having the relevant NFC technology, by using suitable mobile commerce software known to those of ordinary skill in the art, and/or by implementing other known forms of mobile payment solutions. Such mobile commerce software and solutions may include software that enables use of mobile device 96-based digital wallets.

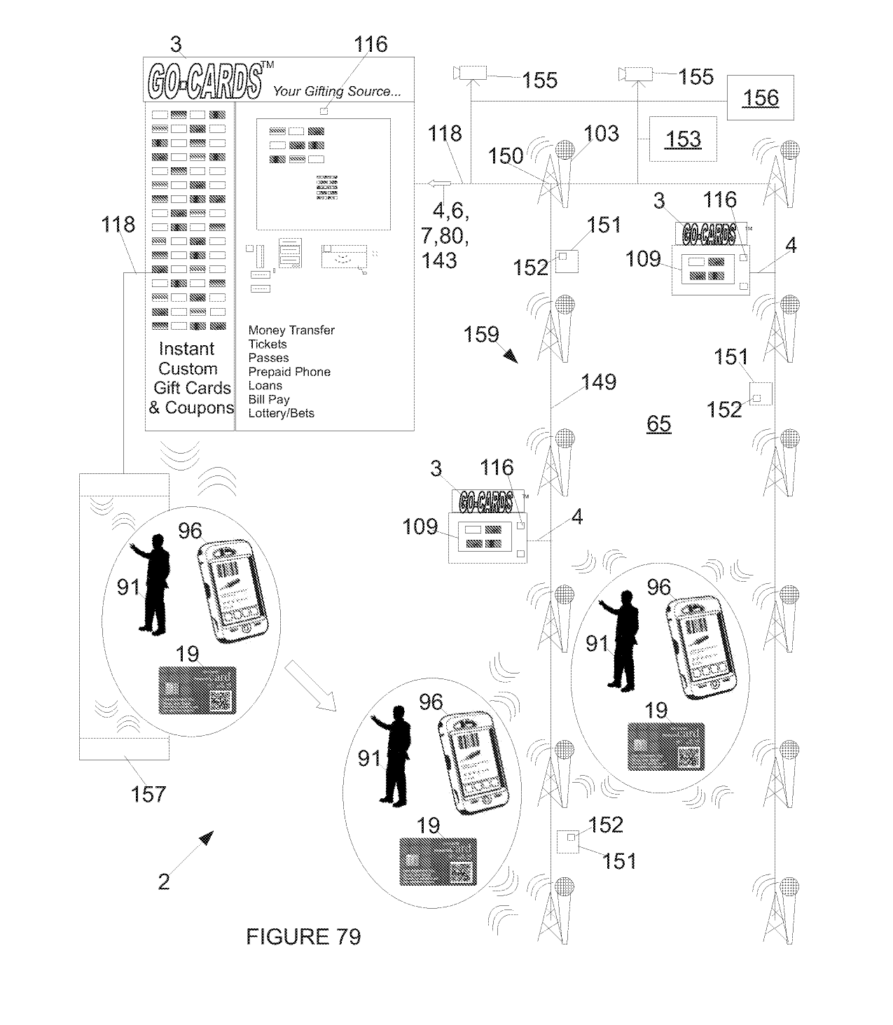

FIGS. 12, 61, 62, 63a, 63b, 65a, 65b, and 79 provide a few non-limiting schematic representations of kiosk architectures configured in accordance with various embodiments of the present technology. As shown in the illustrated embodiments, a kiosk 3 may include a suitable network connection, for example, using connection means 101 for connecting to the internet or other network 118. Internet connection means 101 may comprise, for instance, and without limitation, a wired connection or a wireless connection and/or a wireless device such as a transceiver, which may be suitable for Wi-Fi connections or wireless near field (NFC-based) communications (e.g., Bluetooth). In this regard, a user 91, 92 may seamlessly interact with a system kiosk 3 using their mobile device 96. In some instances, the network 118 may comprise cellular and/or GPS-based networks. The means 101 for connecting to the internet or other network 118 may enable system kiosks 3 to exchange information with one or more remote computers 95, mobile devices 96 (e.g., via a system application), a system website 127, one or more servers 122, 125, 128, 136 or computers 95 or controllers associated with the one or more servers, third-party websites 93, third party groups 94 such as marketing solutions firms, financial institutions, online marketplaces, online auctions, online map functions, online search engines, third party exchanges, clients, etc., via a suitable communication link, network, the Internet, etc. 118.

System kiosks 3 may include a suitable processor and memory, for example, in the form of a central processing unit (CPU) 97 that may serve to control one or more kiosk 3 functions, such as receiving customer inputs 4 directly or indirectly (e.g., from a remote computer 95 or mobile device 96). The CPU 97 may facilitate the sending and receiving of information such as image data 6, audio data 7, user data 8, purchase data 9, redemption data 9, and payment data 10. The CPU 97 may facilitate one or more outputs 5 such as producing a card 19, electronically sending, displaying, or printing image data 6; electronically sending, displaying, or printing a receipt 20; electronically sending, requesting input for, or displaying an email 21; electronically sending, displaying, or printing a confirmation number 22; printing a greeting card 161; electronically sending, requesting, transmitting, or playing audible information 7 in an audible or converted visual format; electronically sending, requesting, requesting input for, or printing a text (e.g., an SMS/MMS/mobile messaging-based communication); electronically sending, requesting, requesting input for, or playing a voicemail 24; electronically sending, requesting, requesting input for, or printing a message 25; electronically sending, requesting, or printing postage 26 or otherwise adding, depositing, withdrawing, sending, or receiving postage-based credits; electronically sending, receiving, converting, calculating, adding, and subtracting currency 27 (including physical and/or digital forms of currency), providing one or more updates 142 to system components; sending, receiving, adding, requesting, monitoring, tracking, storing, displaying, printing, communicating, and/or using location data 143 associated with various system components 2, 3, 19, 65, 91, 92, 121, 127, 147, 151; updating, requesting, receiving, sending, or printing purchase data 9; and/or updating, requesting, receiving, sending, or printing redemption-based data 64, without limitation. It may be appreciated from this disclosure and from the appended drawings that according to certain embodiments, other system components 95, 96, 127, 147 may include features and/or functions which may be similar to those described above.

A user 91, 92, may engage a user interface 106 along with other peripheral devices such as one or more display devices 109, data input mechanisms 117, readers 141, scanners 102, cameras 116, payment receiving mechanisms 100, and payment dispersing mechanisms 111. For example, a consumer 91, 92 may provide one or more inputs 4 via a touch screen, key pad, keyboard, stylus, etc. to provide information to a data storage device or memory associated with CPU 97. The CPU 97 may be any logic processing unit known in the art, including, but not limited to, digital signal processors (DSPs) and application-specific integrated circuits (ASIC). The CPU 97 may comprise a single CPU or multiple CPUs. Memory associated with CPU 97 may include read only memory (ROM) and/or random access memory (RAM), without limitation.

Peripheral devices provided to kiosks 3 disclosed herein may include output devices including visual 109 and/or audio output devices such as a display screen and speakers, respectively, one or more output devices for dispensing various types 72 of physical redemption options, for example, redeemable paper vouchers, paper receipts, paper eGift certificates, cards 19 (e.g., including smart cards and machine readable cards), card facsimiles, wallet-sized cards, prepaid cards (e.g., calling cards, cellular provider credit cards, cards redeemable for services), passes, cash, currency, credit cards, debit cards, codes, coupons, tickets, promotions, offers, lottery tickets, scratch-off tickets, pawn slips, loan/promissory notes, rain-checks, customer loyalty cards, etc.

According to certain embodiments, peripheral devices provided to kiosks 3 disclosed herein, as well as other system components such as a system website 127 and/or system application 147 may include software and/or network-supported communication means for sending, receiving, converting, transferring, and encrypting/decrypting information regarding various types 72 of electronic redemption options, for example, redeemable electronic vouchers, electronic receipts, electronic eGift certificates, mobile/digital wallet-compatible funds or credits, electronic gift cards (e.g., including machine-readable electronic gift cards), electronically redeemable prepaid minutes (e.g., calling minutes, cellular provider credits, credits for services), electronic passes, electronic money/funds, digital currency (e.g., Bitcoin), credit card credits, debit card credits, electronic codes, digital coupons, electronic tickets, promotions, offers, digital lottery tickets, electronic scratch-off tickets, electronic pawn slips, electronic loan/promissory notes, electronic rain-checks, etc. In other embodiments, system components 3, 127, 147 may include other or additional features and/or functions which may differ from those described above.

In still further embodiments, the system and/or method(s) disclosed may include more or fewer components, features, or steps than what is described, without limitation. System “components” such as system kiosks 3, system applications 147, mobile devices 96 utilizing or otherwise communicating instructions to system components, mobile devices 96 employing a system application 147, and/or properly networked computing devices (e.g., devices having access to the system website 127) may exchange information with one another and/or with one or more remote computers (e.g., one or more computers or controllers networked with the system server 128, one or more computers or controllers networked with a third-party server, one or more vendor 65 payment terminals, one or more vendor 65 websites, or one or more active inventory management systems 153, one or more security systems 156, one or more positioning systems 153, etc.) via a web-based interface (e.g., the system website 127) by way of one or more communication links through the internet, cellular network, or other communication network or protocol 118, 150. For example, in some embodiments, communications between system components 3, 127, 147 may be publicly available communications such as internet communications and/or cellular tower-based communications. Moreover, in some embodiments, one or more private network communications, such as intranet-based or other private network may likewise be used. In some embodiments system components may be connected to one or more host computers which facilitate exchanges of information between system components, for example, between system kiosks 3, remote computing devices (including mobile devices 96 and other forms of computing devices 95), servers 122, 125, 128, 136, third party platforms (e.g., marketing solutions 94 systems, social media platforms), websites 93, 127, payment terminals 100, payment systems, components of payment terminals, payment terminal software, (including system-supported and non-system supported payment terminals, payment systems, components of payment terminals, and payment terminal software), active inventory management systems 153, security systems 156, positioning systems 159, and the like. The private network communications may be utilized on the back end of transactions, wherein the front end and receiving end of transactions may utilize public cellular tower-based communications.

A server computer or controller which is associated with the system server 128 may perform some, many, or all of the functions necessary for receiving, sending, and routing electronic messages, storing electronic messages, sending/receiving/storing browser 131 or system website 127 web pages, sending/receiving/storing image data 6, sending/receiving/storing audio data 7 (including sound-wave information and audio files), sending/receiving/storing payment data 10, sending/receiving/storing user data 8, sending/receiving/storing purchase data 9, sending/receiving/storing redemption data 64, sending/receiving/storing voicemails 24, canned messages 25, message templates, messages, postage 26, texts 23, emails 21, confirmation numbers 22, receipts, e.g., electronic receipts 20, system card [19, 100, 200, 300, 400] information, greeting information, e.g., greeting card 161 information, currency 11, 27, information, algorithms, location data 143, etc., which may be necessary to implement the commerce systems described herein.

The server computer or controller may, for example, retrieve and exchange web pages and other content with one or more system databases 129, external databases 135 (e.g., government databases, online exchange databases, e-commerce databases), financial institution databases 138, or databases 137 which are affiliated with a number of vendors or selling entities 65. In addition, in various embodiments a server computer or controller which is associated with the system server 128 may include a server engine, a web page management component, a content management component, and a database management component (none shown). In various embodiments, the server engine may perform the basic processing and operating system level tasks associated with the various technologies described herein. The web page management component may handle creation and/or display and/or routing of web or other display pages. The content management component may handle many of the functions in the mobile commerce embodiments described herein. The database management component may include suitable storage and may perform suitable storage and retrieval tasks with respect to the database 129, query the database 129, and store various data such as animation, graphics, indicia, image data, redemption data, purchase data, payment data, item data, entity data, message data, user data, profile 130, 130′ data, visual and audio signals, etc.

Although not required, aspects of various embodiments may be described in the general context of computer-executable instructions or functions, such as routines executed by a general-purpose data processing device, e.g., a server 128 computer, controller, a wireless device, (mobile) phone, or personal computer. Those skilled in the relevant art will appreciate that aspects of various embodiments may be practiced with other communications, data processing, or computer system configurations, including: internet appliances, hand-held devices (including personal digital assistants (PDAs)), wearable computers, all manner of cellular or mobile phones (including voice over IP (VoIP) phones), dumb terminals, dumb mobile phones, media players, gaming devices, multiprocessor systems, “cloud”-based services/software/hardware accessible by electronic devices, microprocessor-based or programmable consumer electronics, set-top boxes, network PCs, mini-computers, mainframe computers, and the like. Indeed, the terms “computer,” “server,” “host,” “host system,” and the like may be generally used interchangeably herein, and refer to any of the above devices and systems, as well as any data processor.

Aspects of certain embodiments may be embodied in a special purpose computer or data processor that is specifically programmed, configured, or constructed to perform one or more of the computer-executable instructions or functions explained in detail herein. While aspects of embodiments, such as certain functions, may be described as being performed exclusively on a single device, it is envisaged that the embodiments could be feasibly practiced in distributed environments where functions or modules are shared among disparate processing devices, which are linked through a communications network, such as a local area network (LAN), a wide area network (WAN), or the internet. In a distributed computing environment, program modules may be located in both local and remote memory storage devices.

Aspects of certain embodiments, for example, data-driven or software-driven aspects of embodiments, may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of embodiments may be distributed over the internet, cellular networks, or over other networks 118, 150 (including non-cellular wireless networks), on a propagated signal on a propagation medium (e.g., an electromagnetic wave(s), a sound wave, etc.) over a period of time, or they may be provided on any analog or digital network (packet switched, circuit switched, or other scheme).

One skilled in the relevant art will appreciate that the inventive concepts disclosed herein may be used in various environments other than location based-environments, or the Internet. In general, a display description may be in WPF format, HTML, XML or WAP format, email format, SMS/MMS/mobile messaging format, web format, or any other format suitable for displaying information (including character/code-based formats, algorithm-based formats (e.g., vector generated), and bitmapped formats).

Also, various communication channels, such as local area networks, wide area networks, or point-to-point dial-up connections, may be used instead of the Internet. The system may be conducted within a single computer environment, rather than a client/server environment. Also, the user computers or mobile devices 96, 96a, 96b may comprise any combination of hardware or software that interacts with the server 128 computer or CPU, such as television-based systems and various other consumer products through which commercial or noncommercial transactions may be conducted. The various aspects of the embodiments described herein may be implemented in or for any e-mail environment, as well as SMS/MMS/mobile messaging-based texting platform environment. Although specific circuitry is described above, those or ordinary skill in the art will recognize that a micro processor-based system could be used where any logical decisions are configured in software.

While many of the embodiments are shown and described as being implemented with hardware, such as one or more integrated circuits which are designed for a specific task, it should be understood that such embodiments could equally be implemented in software 147, including mobile software and be performed by one or more processors within a kiosk 3, CPU 97, user's mobile device 96, user's computer 95, etc. For example, such software 147 may be stored on any suitable computer-readable format or medium, such as microcode stored in a semiconductor chip (whether in/on card 19, 100, 200, 300, 400, user mobile device 96, or user computer), on a computer-readable disk (e.g., data disk 28, server 128 CPU 97, database 129), or downloaded from a server 128, 122, 136, 125, and stored locally at a client.

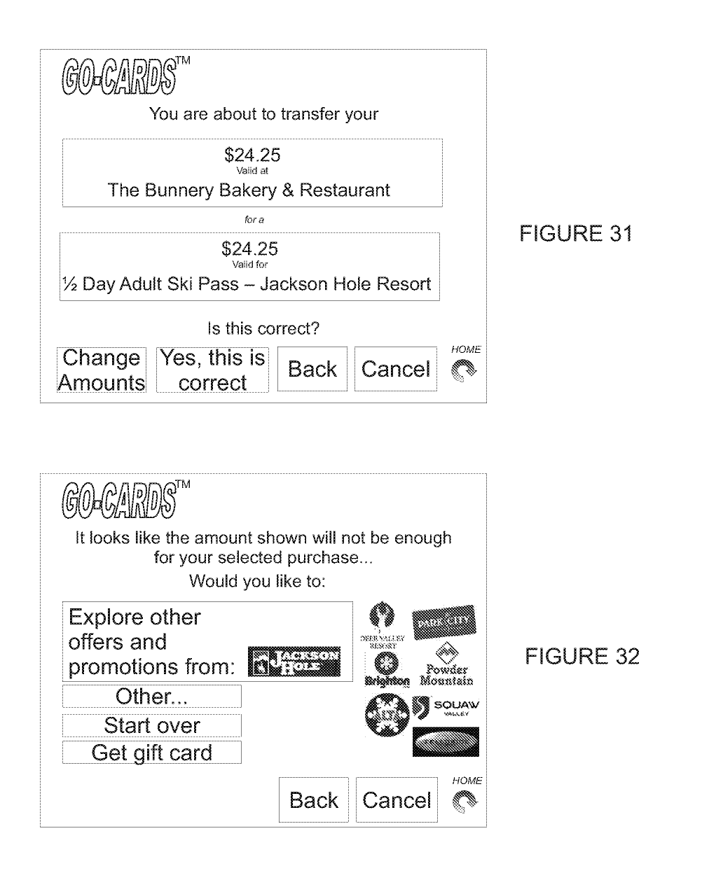

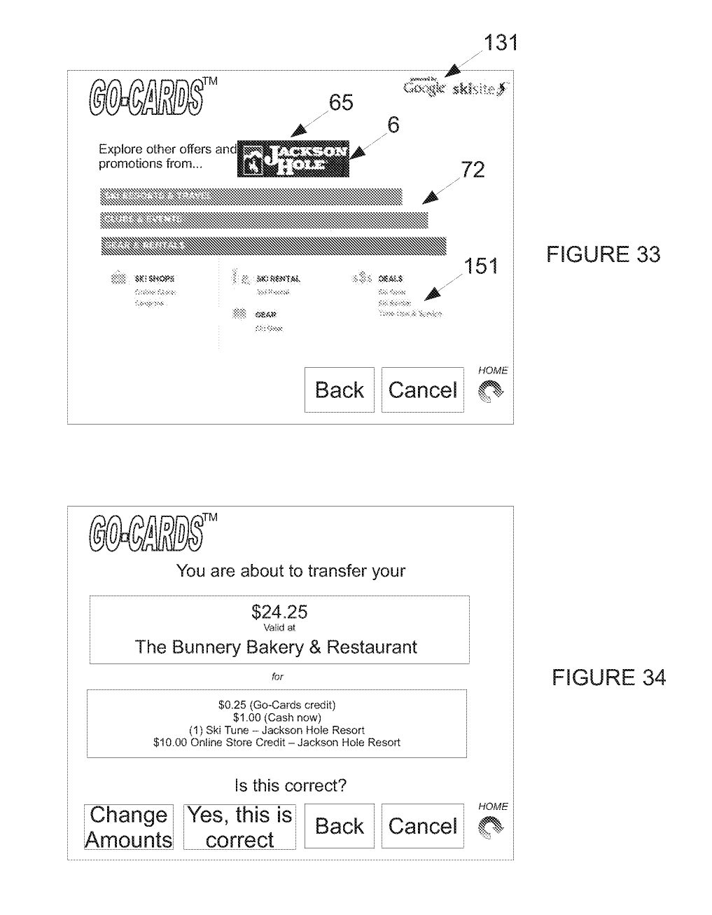

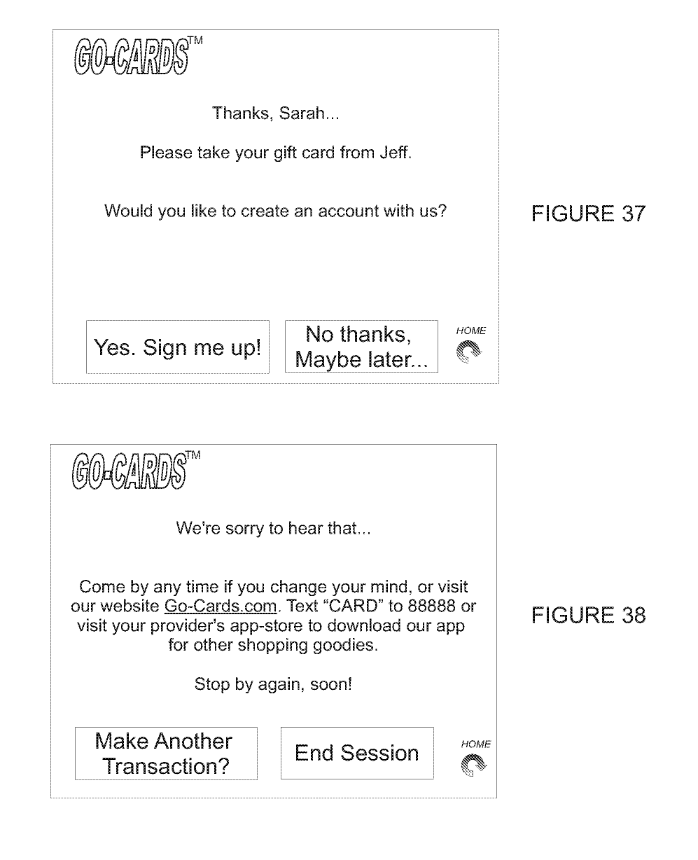

Referring to FIGS. 21 through 23, 27-38, and 64, representative displays (e.g., web browser pages, screenshots, system application window) may be provided to a user's mobile device 96, kiosk 3, and/or computer 95 components during use of the system. The particular representative displays shown in FIGS. 21 through 23, 27-38, and 64 are especially suited for a system kiosk 3. The displays may be implemented in any of various ways, such as in C++ or as web pages in XML (Extensible Markup Language), HTML (HyperText Markup Language), or any other scripts or methods of creating displayable data, such as using WAP (Wireless Access Protocol). It will be apparent from the representative screenshots, web pages, and application-based displays shown in the drawings that various tasks may be assigned and/or managed by the system or components thereof according to user inputs 4 delivered to user interface 106.

The system browser 131 pages, including browser pages of a system website 127, may provide an interactive vehicle for a user 91 to present input data 4 to a component of the system such as a system kiosk 3, system website 127, and/or system application 147, and/or to manipulate database information. The system component may receive one or more pieces of input data 4 from a user 91, such as a form or page with fields to be filled in, icons to be touched, menus to be selected from, pull-down menus to be selected from, or one or more entries to be entered, thereby allowing one or more many redemption options to be selected, and/or functions to be performed. Browser buttons, hypertext links, sliders, back and forward buttons, return to home buttons or other known user interface tools for receiving user input 4 may be used. While certain foreseeable ways of displaying information to system users are shown and described, it will be appreciated by those being skilled in the relevant art will instantly recognize that various other alternatives may be employed.

Browser 131 pages, screen displays, and image information provided to users while utilizing system components 3, 127, 147 (e.g., website, system mobile application) may be stored as display descriptions, graphical user interfaces, or other methods of depicting information on a computer screen (e.g., commands, links, fonts, colors, layout, sizes and relative positions, and the like). For example, browser 131 page layouts and information or content to be displayed on a given browser 131 page of a given system component 3, 127, 147 may be stored in a system database 129 communicating with a system server 128.

Where used herein, a “link” may refer to a resource locator identifying a resource on the system network, such as a display description provided by an organization having a site or node on the system network. A “display description,” may refer, generally, to any method of automatically displaying information on a display in any of the above-noted formats, as well as other formats, such as email or character/code-based formats, algorithm-based formats (e.g., vector generated formats), or matrix or bit-mapped formats. While certain examples of embodiments may be described herein using a networked system involving multiple system components (e.g., multiple P-O-S checkout terminals) communicating with each other via the internet, cellular network, cellular service provider, SMS messaging center, or other network 118, it should be understood that some or all of the system features and/or advantages described herein may be implemented using a single-computer 95, a single mobile device 96, single system kiosk 3, and/or single terminal.

FIGS. 27-38 present various screenshots/display pages that could be implemented with system kiosks 3, although it is anticipated that similar displays may be provided to a system website 127 or a system application 147 such as a mobile application. As the screenshots suggest, a customer may have access to a wide variety of options for purchasing funds or credits, converting funds or credits, redeeming, or otherwise utilizing funds or credits, as well as sending funds or credits to other individuals. The display pages may be presented to the user in response to the user inputting payment data 10 (e.g., cryptocurrency, gift card credit, system-based credits, miles, points, rewards, cash, or other form of payment discussed herein), selecting an appropriate prompt, pressing a “begin” button, and/or other ways. The screenshots may, for example, be provided on display means 109. The displays may be presented to enable a user to view a list of options in an electronic “online-style” market, identify favorites 140, add favorites 140, view favorites 140, and see favorites 140 or “Likes” of friends 145. Display means 106 may provide an abundance of redemption options of various types 72. For example, the user interface 106 may prompt a user for a cash redemption 11, a credit-based redemption 12, a credit to the customer's 91, 92 credit card account, a debit-based redemption 13, a credit to the customer's 91, 92 debit card account, a check-based redemption 14, a points-based redemption 78, a gift card redemption 15, a voucher redemption, a coupon-based redemption 16, code-based redemption, a system account credit-based redemption 17, a cryptographic currency-based redemption 18, a traded fund-based redemption 81, a ticket-based redemption 75, a pass-based redemption 67, a coupon-based redemption 16, a lottery-based redemption 82, a pawn or loan ticket-based redemption, a receipt-based redemption 20, a greeting card-based redemption 161, a prepaid minutes-based redemption 76, a check-based redemption 14, and postage-based redemption 25. Such redemption options may include an option to receive cash or an alternative form of funds or credits as change in return for a different type of received fund or a credit or fund or credit associated with a user's profile 130 (i.e., system account).

Non-limiting examples of redemption options (e.g., gifting options) may comprise obtaining or sending physical or electronic gift cards 15 relating to a particular vendor or entity 65 (e.g., a Starbucks®, Subway®, Barnes & Noble®, iTunes®, Target®, Wal-Mart®, IKEA®, or Home Depot® gift card), obtaining or sending physical or electronic gift cards 15 relating to a particular product, service, good, brand, line, or portfolio 151 (e.g., a Hershey's®, Levis®, Martha Stewart's Living®, Nine West®, Samsung®, Gillette®, Nike®, Pepsi®, Gucci®, Frito Lay®, Kraft®, Volkswagen®, Shell®, Chanel®, Heineken®, Sony®, Heinz®, Tabasco®, Nabisco®, Nestle®, General Mills®, Netflix®, TracFone®, Redbox®, or General Electric® gift card), making an electronic donation to a charity personally or in another individual's name (e.g., St. Jude's Children's Hospital/ALSAC, Ronald McDonald House, ASPCA, United Way), adding additional miles to an existing (e.g., Delta SkyMiles®, United MileagePlus® miles, American Airlines AAdvantage® travel awards) user account—such as a personal account or other individual's account, purchasing or sending a personal coupon or a coupon for another individual or group (e.g., free bowling and shoe rental for additional lane players with the full price purchase of two adults for the same lane, Free Appetizer with Applebee's entree), purchasing or sending a personal pre-paid voucher (e.g., “Enjoy 3 free introductory guitar lessons from AJ”, or “Free introductory flight in a Cessna 172 through Philips Aviation school”, “Learn to swing dance in 8 classes with Emma Lee”, “Pottery 4 Dummies class”, “Free 2 hour photography workshop with Ryan”, or “FREE up to 5 quart synthetic oil change from Jiffy-Lube®”), receiving a physical or electronic check 14 (e.g., including an image or icon, rain check, certified check, cashier's check), a physical or electronic receipt 20 for a purchased stock, mutual fund, or tradable asset, receiving or sending a personal credit card 12 or credit card credit, receiving or sending a gift credit card 12 or credit card credit in a recipient's name, receiving or sending gift credit or store credit in a recipient's name, receiving or sending a personal debit card or debit card credit, receiving or sending a debit card or debit card credit to a recipient, receiving a lottery ticket 82 or sending a lottery ticket 82 or credit to purchase a lottery ticket to another individual (e.g., Virginia Lottery, MegaMillions, Powerball), purchasing or sending a ticket (e.g., a machine-readable UTA transit pass, a public transportation ticket, a sporting event ticket, a play ticket, a theatre ticket, a movie ticket, a concert ticket), paying for another individual's speeding ticket, purchasing or sending a pass (e.g., a EuroRail Eurail pass, a club VIP pass, a machine-readable UTA transit pass, a direct-to ski lift ALTA pass, a WMATA DC Metro area pass), purchasing an eGift certificates (e.g., Amazon.com®), adding or sending points to an existing points account (Sonic Cruisers Club points, Subway® points)—such as a personal account or other individual's account, purchasing and/or sending one or more eCertificates (from, for example, Amazon.com®), sending and/or depositing money (e.g., coins, paper currency, credit, electronic money, etc.) into an account 17, and/or withdrawing money, such as electronic money, from a personal or other individual's account (e.g., from a PayPal® or other online account), and/or purchasing an item, product, good, or service online from a checkout page, without limitation.

Any one or more of the aforementioned redemption options (e.g., electronic gifts) may be personalized or customized in some way with image data 6, text 30, audio, or video (e.g., in the form of messages 41 or name 47). The redemption options may be provided with an option to make “non-transferable” or “non-exchangeable”; for example, to assure a donor of a gift that only the recipient may utilize a redemption option for its intended purpose. The redemption options may be provided in a physical or electronic format, and may be utilized for instant use by the purchaser or sent by the purchaser to another individual, for instance, to the other individual's system profile 130, or third party profile 130′. While not shown, a stylus or digital pen type instrument may be employed on a system kiosk 3 to obtain customer inputs 4 which include a customer signature. Similarly, a system application 147 may comprise software which enables a user to sign with a fingerprint or make a finger gesture in the air, or on a touch screen in an appropriate prompt field. For example, a customer 91 may utilize a stylus to sign a digital check or verify that a transaction conducted at a system kiosk 3 is authorized by the customer 91. In another example, a user wearing a wearable mobile device, such as an optical head-mounted display (OHMD), may use their extended finger in front of the optical head mounted display to gesture a signature which is tracked by imaging tracking software and recorded by the wearable mobile device to serve as a physical signature. Moreover, an eye tracker associated with an OHMD may record a user's eye movements which may serve as a physical signature for authenticating a system transaction.

Users may be presented with a number of different types 72 of redemption options, such as goods, services, promotions, or offerings when using the system. Redemption options may be sorted and/or categorized in order to prevent/limit user confusion and improve customer experiences with the system. For example, a user of the system may wish to select from a list of presented redemption options based on alphabetical order of vendors/entities 65. A user may sort redemptions based on the particular type 72 of redemption option. A user may add or remove certain redemption options from their favorites 140. A user may configure their preferences 63 such that their favorite 140 redemption options are displayed, and/or only their favorite 140 redemption options are displayed.

User-selected redemption options and types 72 of purchase data 9 or redemption data 64 which may have been purchased or given to a user may be stored on one or more networked servers (e.g., the system server 128) and then re-accessed by the user via a system kiosk 3 (such as another kiosk in the system), the system website, or a system application 147 (e.g., mobile app) the next time the user accesses their profile 130. Redemption options may be stored, received, sorted, and/or filtered in various ways.

A user of the system may log into a system website 127 using the internet or other network 118. The system website 127 may be associated with one or more kiosks 3 within a network of kiosks 3 which communicate with each other on a shared system-integrated network. The user may access the system website 127 via a remote computer 95 (e.g., a tablet, a personal computer, a web-based digital television system or service, a gaming device (e.g., Nintendo Wii, Microsoft X-box, Sony PlayStation, etc.)) or a personal handheld or portable device such a tablet, mobile phone, PDA, laptop, portable gaming console, or any other small device with access to the system website 127) to access their user profile 130. While in a user profile 130, a user 91 may, set, change, and/or view one or more user profile 130 parameters such as a user's preferences 63, favorites 140, friends 145, shopping lists 144, payment data 10, redemption data 64, purchase data 9, user data 8, audio data 7, image data 6, transactional or interactional history(ies) 146 with the system, etc.

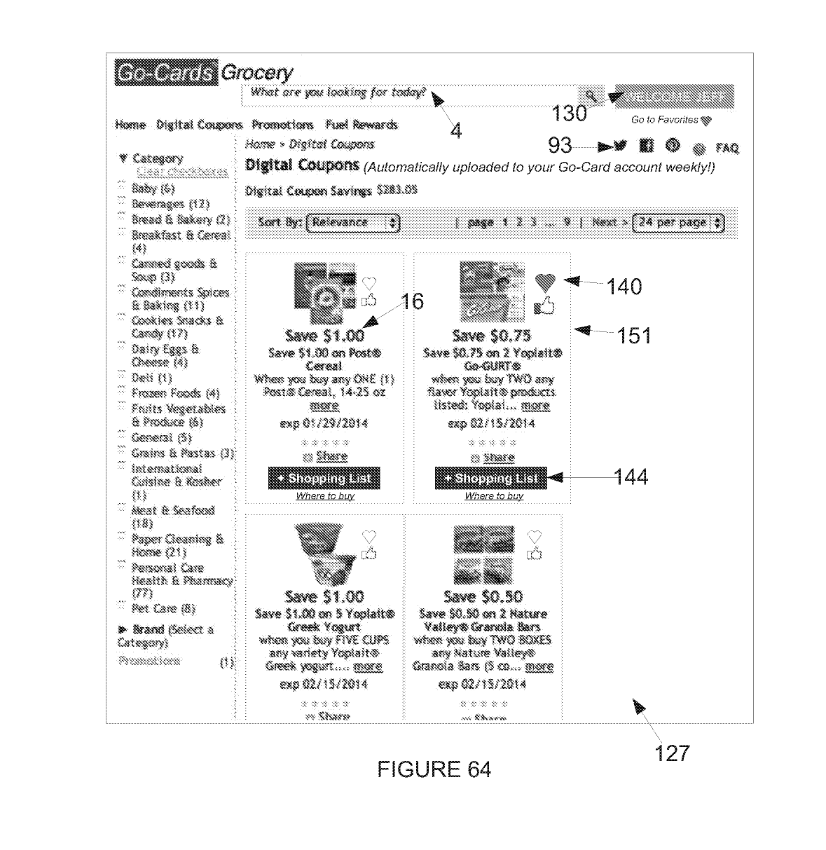

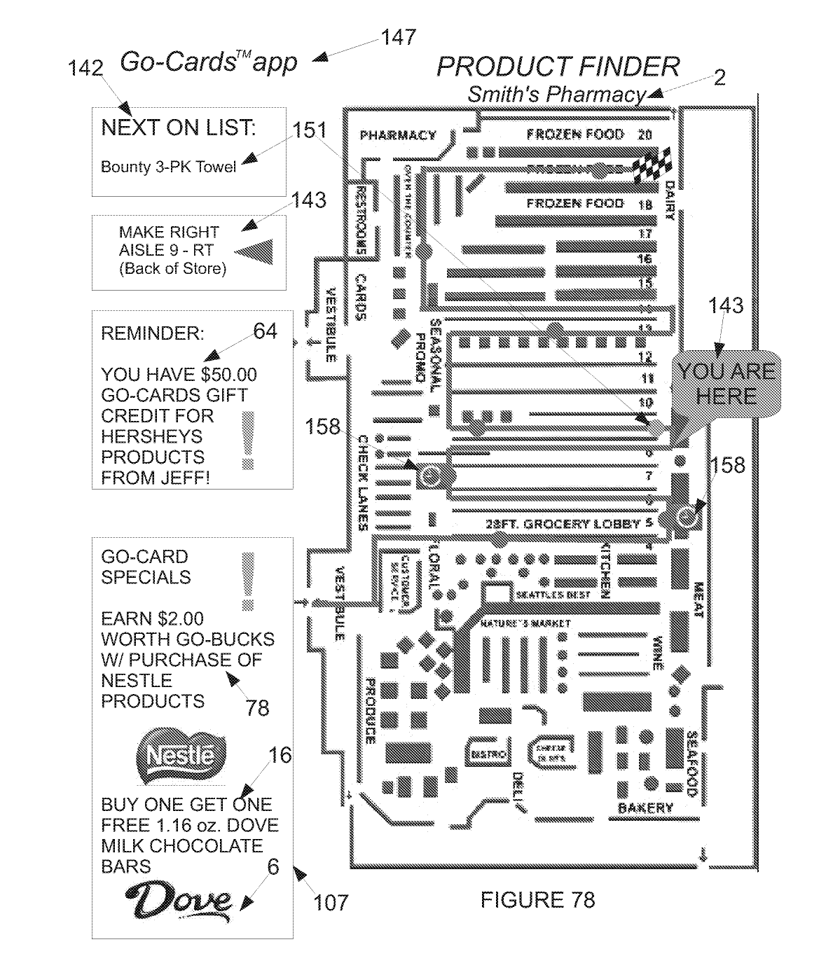

While in a user profile 130, a user may learn and determine which kiosks 3 offer a particular type 72 of product/service/offering 151, where to find local and/or remote kiosk 3 locations, other location data 143 regarding participating vendors/entities 65, venues or locations 2, products/services/offers 151, etc. A user 91 may identify product/service/offering information 151 with regard to a particular location (e.g., in a recipient user's geographic location) or venue/location 2, identify types 72 of products/offerings/services associated with the user's selected favorites 140 or “likes” from a third party social network 93, identify types 72 of products/offerings/services associated with selected favorites 140 or “likes” from a recipient, friend, or follower 145 associated with a third party site 93 or application 148 such as an online social or professional network. FIG. 64 illustrates one possible representation of a screenshot of a user 91 browsing the system website 127. In particular, FIG. 64 shows a grocery-based page of a system website 127 which is suitable for allowing a user to add groceries to a digital shopping list 144 which is maintained on the system profile 130. It is envisaged that similar pages may be available on the system website 127 for clothes shopping, services shopping, entertainment shopping, electronic/digital item shopping, or shopping for other various goods and/or services. A user may login to their profile 130. A number of offers, such as digital coupons from one or more non-affiliated vendors or entities may be automatically applied to the user's profile 130. The digital coupons may be automatically removed from the user's profile 130 when the digital coupons expire. A user may add a product, good, or service as a system favorite 140, or “like” a product, good, or service using a third party application 148 such as Facebook. Once an item is added to a user's shopping list, the user may use a system application 147 on their mobile device 96 to track the location of the item within a structure of a vendor or entity 65. For example, as shown in FIG. 64, a user may add Yoplait Go-Gurt to his or her shopping list 144 by pressing a “+Shopping List” icon. The user may then walk into a grocery store which sells Yoplait Go-Gurt. The user may use a system application 147 on the user's mobile device 96 to access their shopping list 144. As shown in FIG. 78, the user may be directed to the location of the Yoplait Go-Gurt using the system application 147.

Alternatively, the system website 127 may comprise a “Where to Buy” link or icon. A user may press the “Where to Buy” link or icon to show a listing of all vendors or entities 65 which carry or otherwise sell Yoplait Go-Gurt, particularly vendors or entities that are most local to the user. When clicking on a specific vendor or entity 65 (i.e., a hyperlink showing the name of a specific vendor or entity 65), the user may be directed to a separate page showing the location within the specific entity 65, that the Yoplait Go-Gurt may be purchased. In this regard, a customer need not waste time searching the store of the specific vendor or entity 65 for the desired Yoplait Go-Gurt. For example, a user may press the “Where to Buy” link for Yoplait Go-Gurt and then be sent to a page listing a number of unaffiliated vendors/entities 65 which sell Yoplait Go-Gurt. The user may then select a “Safeway (0.21 miles from you)” hyperlink. The hyperlink may then take the user to a page showing a store layout of the user's local Safeway grocery store. The layout may contain a marker or indicator, such as an “X” showing an approximate or precise location of where, in relation to the store layout, Yoplait Go-Gurt may be found within the Safeway store. Alternatively, the hyperlink may take the user to a page showing the aisle number, the correct side of an aisle, a distance down the aisle, etc. corresponding to where the store currently stocks Yoplait Go-Gurt. Even more alternatively, a user may move a mouse over the “Where to Buy” link or icon, and a pop-up may appear indicating the closest vendor or entity 65 to the user which sells Yoplait Go-Gurt, along with information regarding where the product is located within a structure of the closest vendor or entity 65. It will be appreciated by those having an ordinary skill in the art that alternative embodiments and methods for suggesting location data 143 pertaining to particular goods or services 151 are anticipated.

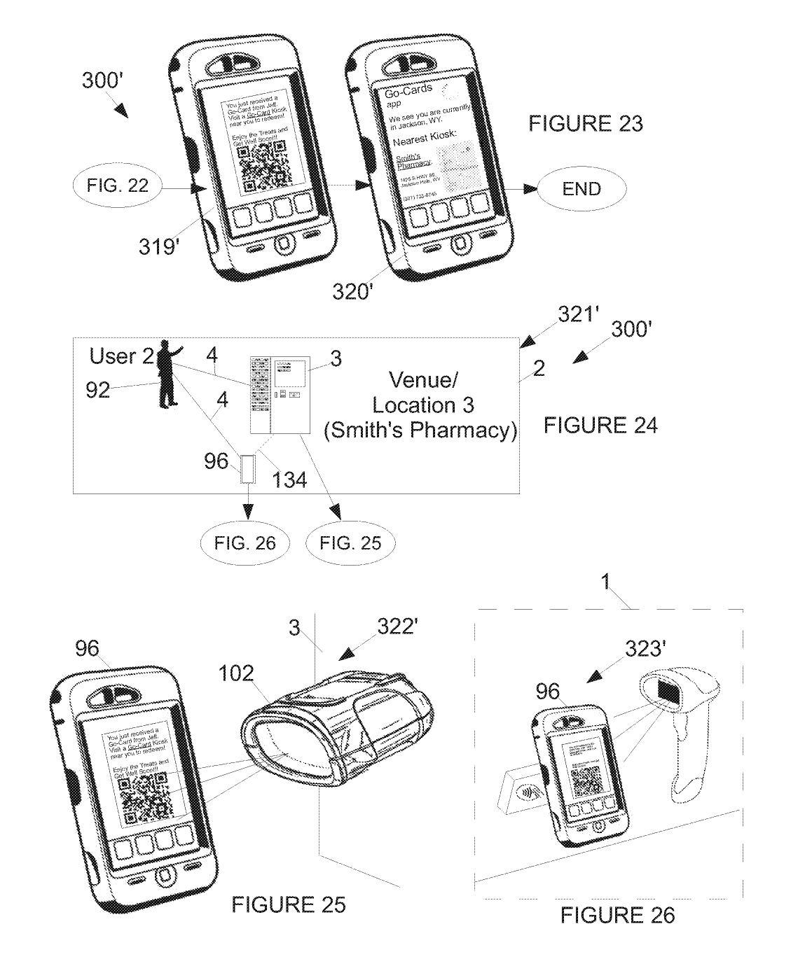

Display means 106 may include an illustrative replication of a card 19, greeting card, or facsimile of electronic card information that the user may receive in exchange for funds or credits provided to the system by a user 91 in the form of payment data 10. A user 91 may elect to select a type 72 of redemption option available using the system browser 131. A user may add an amount to put on a card 19 relating to the selected type 72 of redemption option by entering an amount when prompted by the kiosk 3. Alternatively, a user may add an amount to put on a user profile 130 relating to the selected type 72 of redemption option by entering an amount when prompted by the system website 127 or system application 147. The user profile 130 may be or may comprise the profile of the user adding the amount, or it may be or may comprise a user profile 130 of another user, such as a friend 145 of a user adding funds or credits. The user may deposit additional funds for the card 19 with an “add to card” button (not shown). Selecting a “back” button on the system browser 131 may return the user to the previous screen. Selecting a “home” button on the system browser 131 may return the user to a user′ homepage 139. Browser 131 may be associated with any component 3, 127, 147 of the system. Browser 131 may comprise a confirmation page 134 such as the one shown in FIGS. 22, 23, 31, 34-36, 89a-89d, and 90a.

FIGS. 22, 29, 30, 35, 64, 65a, 65b, 87, 88, 89a-89e, and 90a-90e illustrate possible non-limiting examples of how kiosk 3, system website 127, and/or system application 147 displays provided to a user 91 may be suitable for implementing various aspects of a method for sharing a user's experiences with system components with one or more other people (e.g., “friends” 145) via a third party social media website 93, such as Facebook®, Twitter®, LinkedIn, YouTube, etc.

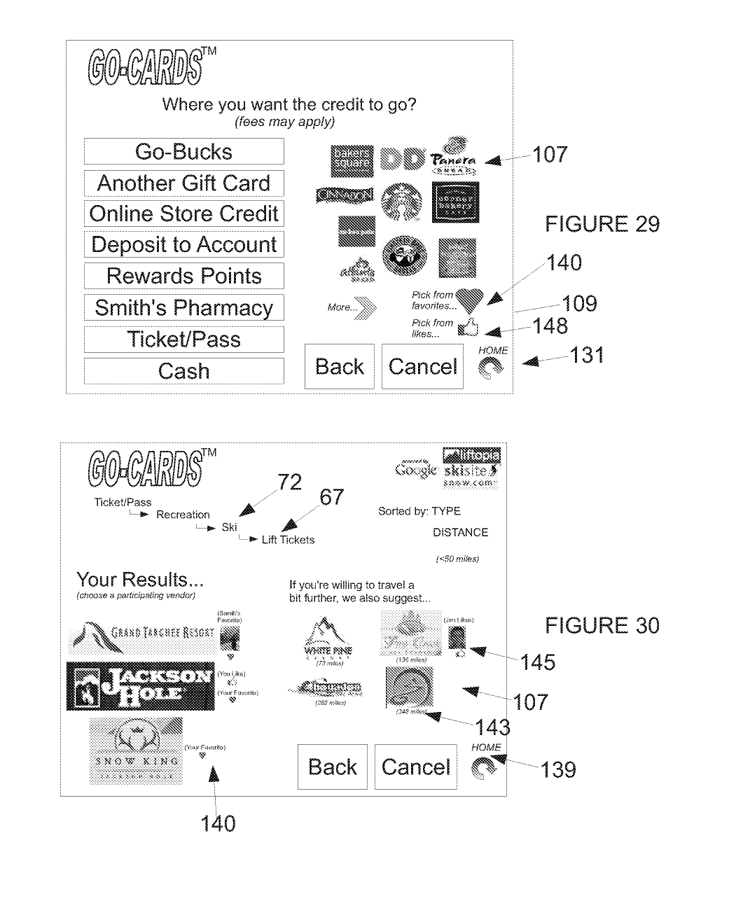

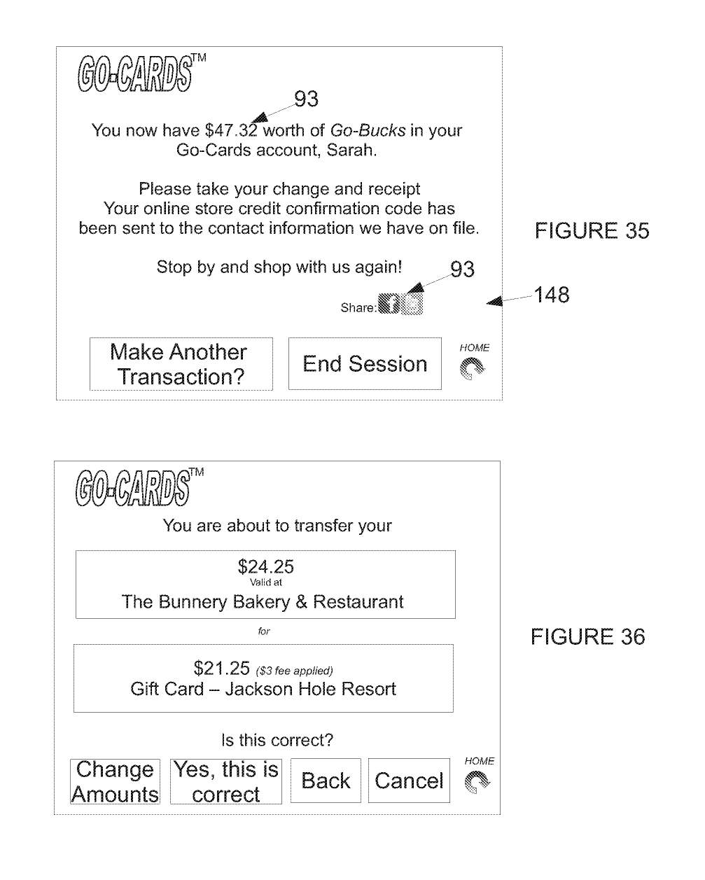

A user 91 of the system may enter information regarding or link a third-party account, such as a social network 93, to share information between the third-party account and the system account by setting up user password and login information relating to the third-party account in their system preferences 63. This setup may be done via the system website 127, system application 147, or kiosk 3. As shown in steps 313′ and 316′ of FIG. 22, FIG. 29, FIG. 30, and FIG. 35, a user may have access to and may interact with information provided by the third-party account, such as “likes” or favorites information 140 of the user 91 or of the user's friend(s) 145 of the system and/or friends of a third party application 148.

Displays provided by components of the system may display a field that displays a running total of the user's payment data 10.

For example, a system kiosk 3 may display a total amount of funds or credits deposited to the kiosk 3 during a single transaction or for a total net of all deposits made through a number of system kiosks 3 or through other system components such as the system website 127 or system application 147. Users may elect to insert bills or coins to a kiosk 3 as a form of payment data 10 during inputs 4, and the kiosk 3 may present a total amount of deposited bills or coins. It will be appreciated that a system kiosk 3 may show information pertaining to the types of denominations deposited, such as the number or separate total amount of $100 dollar bills, $50 dollar bills, $20 dollar bills, $10 dollar bills, $5 dollar bills, $2.00 bills, $1.00 bills, half dollars, quarters, dimes, nickels and pennies inserted. counted by the machine. A final total may be displayed, and the user may convert the cash currency funds to another form of funds or credits (i.e., payment data 10), such as system-based credits cryptocurrency, a check, postage-based credits, a money order, a check, digital wallet funds, or the like. As discussed herein, a user may utilize system-based credits to purchase various redemption options provided by the system which are searchable and purchasable via the system browser 131. Remaining or leftover funds or credits may be discharged, for example in the form of change (bills or coins), via payment dispensing means 108. When a user is finished, he or she may elect to end their session by pressing a “quit”, “cancel”, or “log out” button (not shown).

Various embodiments may provide personalized automated shopping experiences through integration with social networks 93, allowing users 91, 92 to share their individual experiences with friends 145. Integration of social media websites 93 may enable users 91, 92 of the system to integrate specific information about their own favorite goods, services, promotions, and/or offers with the system. Moreover, integration of social media websites 93 may enable users 91, 92 of the system to integrate specific information about goods, services, promotions, and/or offers that are “liked” by friends 145 with various components 3, 127, 147 of the system.

Social network 93 friends' 145 previous transactions and interactions may be displayed by components 3, 127, 147 of the system. Moreover, users' experiences while using system components 3, 127, 147, such as purchasing or receiving goods or services may be automatically customized with information obtained from a social network 93. According to some embodiments (an depending on set user preferences 63), a user may be able to publish information on a social media site 93 automatically.

FIG. 27 illustrates a representative display page for logging in to a user account and/or profile 130 from a system-integrated kiosk 3 in accordance with one embodiment of the present technology.

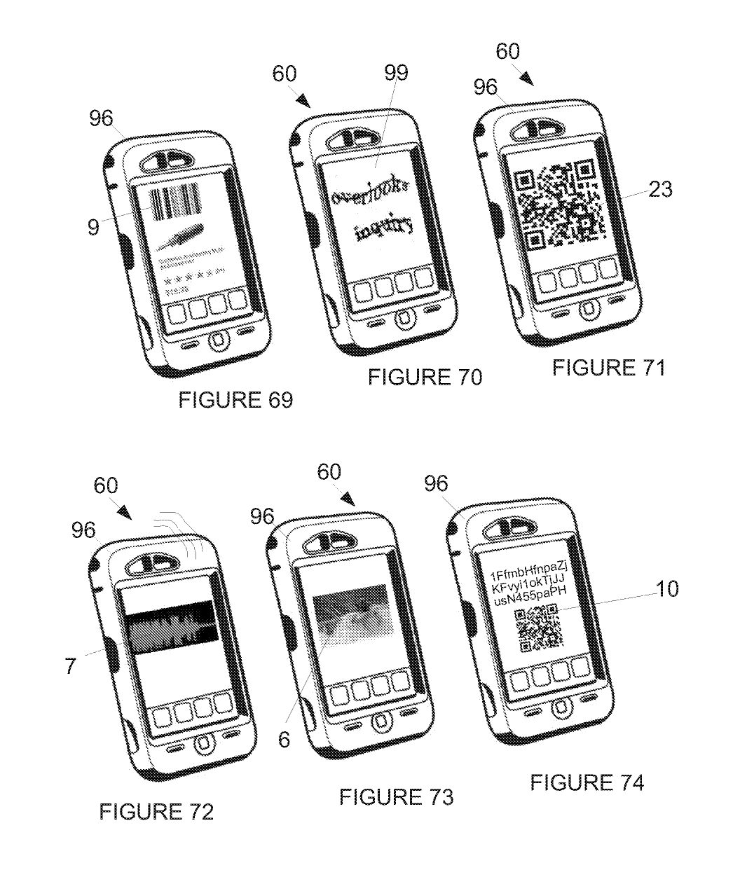

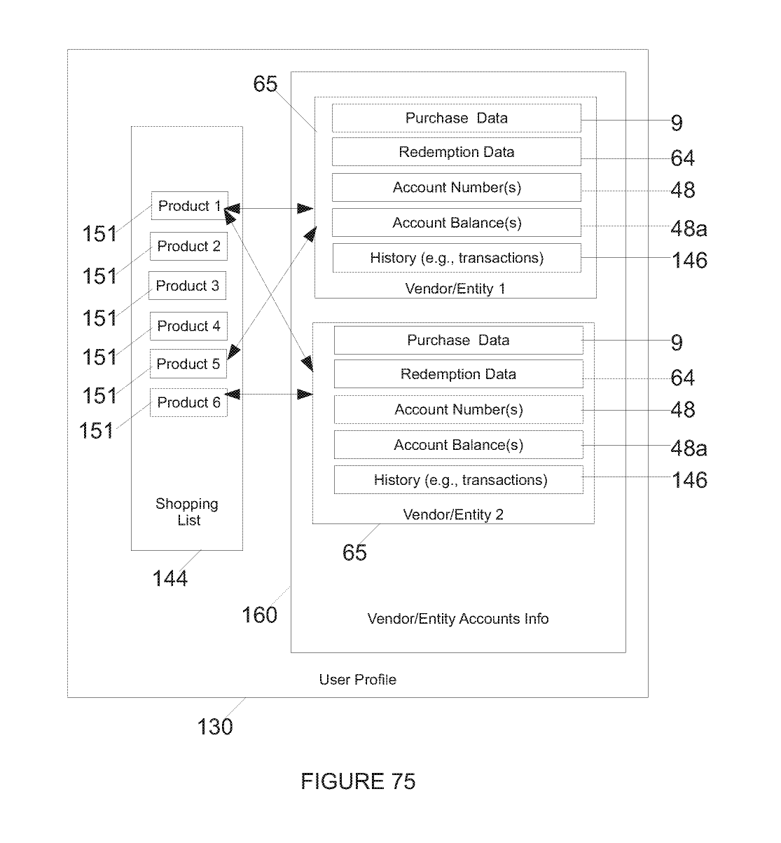

In some embodiments, a user may log into a system kiosk 3 with the aid of a mobile device 96. For example, a user may, via the user interface 106, be presented with an option to send login information to the user's mobile device 96. In other words, if the user wishes to log into the system kiosk 3 using their cell phone number rather than by their email address, system account number, etc., the user may select a “Send PIN by SMS” icon (not shown), and type their phone number into a phone number prompt field using, for instance a touchpad associated with display means 109. In such an instance, the user may then press a “send” icon which may cause a one-time use password to be sent to the user's mobile device 96. The user may then speak aloud the one-time use SMS password received by their mobile device 96, or physically type the SMS password into a designated field provided by the system kiosk 3. In some embodiments, an MMS password may be sent to the user, which may include image data as shown in FIGS. 69-74, or even audio data as shown in FIG. 72. Image capture means 116, scanner means 102, and/or audio input means 103 may read the information sent to the user's mobile device 96 to confirm/verify the user's identity and authenticate access to a user profile 130. Such security measures may be used between various components of the system, including at various points of sale with participating vendors/entities 65. Routines of system components 3, 127, 147 may include receiving funds or credits in the form of payment data 10, and then counting or otherwise determining a value of the funds or credits received. The value of the funds or credits received may be in terms of a native unit (e.g., US dollars), or they may be converted by a system component (e.g., kiosk CPU 97, system website 127, or mobile device processor supporting a system mobile application 147) into system-based credit units. Routines may comprise determining a total value of funds or credits received. Routines may include counting funds or credits received to determine the total value of funds or credits received. Routines may include displaying one or more redemption or transaction options. For example, routines may include prompts to a system user 91, 92 requesting the selection of one or more types 72 of redemption options (e.g., a withdrawal, a deposit, a purchase, a conversion, a transfer, etc). Routines may include one or more checks to determine if a user has provided any inputs 4 which relate to selected redemption options (e.g., purchase data 9 or redemption data 64). In some embodiments, routines may include sorting various redemption and/or transaction options according to user preferences 63. In some embodiments, routines may include identifying favorite redemption options. In some embodiments, routines may involve receiving one or more additional inputs 4 with respect to various available redemption options. In some embodiments, the one or more additional user inputs 4 may change a visual display and/or arrangement of the redemption options. In some embodiments, if a routine receives one or more additional user inputs 4, the routine may save the one or more additional user inputs 4 so that they may be available to the user the next time the user logs in or otherwise accesses their profile 130 via a system component 3, 127, 146. Routines may include providing a selected product, good, service, offering, or promotion associated with the selected redemption/transaction option to the user. Routines may include receiving an input 4 from a customer requesting to end a routine, wherein a routine ends.

Routines may include personalizing one or more redemption options in a variety of manners depending on inputs 4 received. Routines may include displaying various graphics, icons, buttons, links, data (e.g., purchase data 9, redemption data, location data 143) and/or other information that, when selected by a user, may automatically send an electronic message, such as a text message, a “Tweet”, a post, a multimedia message, a voicemail, or an email. Routines may include sending information to one or more third party computing devices 95, sites 93, firms 94, databases 129, 135, 137, 138, servers 122, 125, 128, 136, 163 or electronic addresses (e.g., mobile devices 96, user profiles 130). The electronic message or information sent may include information related to a user transaction (e.g., purchase data 9, payment data 10, redemption data 64, etc.). Routines may include checks regarding requests to send an electronic message or information related to a user transaction. Routines may include verifications, for instance, to determine if an electronic message or information has been received. Routines may include requesting a user to upload information, or utilize uploaded information. Routines may include requesting a user to download or receive information, or utilize downloaded or received information. Routines may include inputs 4 such as permissions to provide information to various parties (e.g., to third parties, websites, vendors or entities 65, social media sites 93, firms 94, financial institutions, the system website, etc.).

FIGS. 2-3b illustrate various iterations of a system kiosk 3 according to various embodiments. Kiosks 3 may be affiliated with a plurality of kiosks 3 included within a system having a plurality of such kiosks situated at a plurality of hosting venues or locations 2. The kiosks 3 of the system preferably form a network. As such, the kiosks 3 are preferably in communication with each other and/or with a central system server 128 or central controller (not shown). As shown in FIG. 14, each kiosk 3 may include a CPU 97 having one or more processors and/or controllers therein. The CPU 97 is operatively connected to a user interface control system which may support a user interface 106. Kiosk CPU 97 may support, without limitation, one or more kiosk-provided image capturing devices 116, display screens 109, internet connection devices 101, security protocols 99, payment receiving devices and/or software 100, image/graphic data scanning devices 102, hardwire link devices 114, audio input devices 103, power supply devices 113, databases 128 or database access systems 112, printing devices 104, data input devices 117, reader devices 110, advertising systems or platforms 107, payment dispensing devices and/or software 108, receipt devices and/or software 141, data disk readers 115, digital writers 119, card dispensing devices 111, card storage devices 123, card production devices and/or systems 98, system clients 162, and/or greeting card production devices 105, “the peripheral devices.” The CPU 97 is capable of executing various programs to provide inputs to and/or receive outputs from the peripheral devices. Suitable processors for use within a CPU 97 are generally known to those having skill in the art. The CPU 97 is operably connected to at least one memory storage device, such as a hard-drive or flash-drive or other suitable memory storage device as will be appreciated by those skilled in the art. For example, memory storage devices may include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory storage devices may incorporate electronic, magnetic, optical, and/or other types of storage media. Memory storage devices may have a distributed architecture where various components are situated remote from one another, but are still accessed by processor within the CPU 97. A system database 129 may be operatively coupled with, or form a portion of a CPU 97 memory storage device. In some preferred embodiments, a system may comprise a network of kiosks 3 in communication with one another and with a system website 127 and a system application 147. As shown in FIG. 12, in one preferred configuration, the system kiosks 3 are networked with one another via a central system server 128 or central system controller in a hub-and-spoke system. However, optionally, the kiosks may be connected and communicate directly with one another, and/or certain subsets or groups of kiosks 3 may communicate with one another directly as well as with the system server 128.

Generally, in terms of hardware architecture, the system server 128 includes a central processor and/or controller, central memory, and one or more input and/or output (I/O) devices (or peripherals) that are communicatively coupled via a local interface. Numerous variations of the architecture of the system server may be understood by one of skill in the art and are encompassed within the scope of the present invention.

Steps and/or elements, and/or portions thereof of the systems and methods described may be implemented using a source program, executable program (object code), script, or any other entity comprising a set of instructions to be performed. When a source program, the program may be translated via a compiler, assembler, interpreter, or the like, which may or may not be included within the memory, so as to operate properly in connection with the operating system (O/S). Furthermore, software embodying the systems and methods described herein may be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. frequency (RF) or other transceiver, a telephonic interface, a bridge, and a router.

When a kiosk 3 of the system is in operation, a processor associated with its central processing unit (CPU) 99 is configured to execute software stored within kiosk [3] memory, to communicate data to and from the kiosk memory, and to generally control operations of the kiosk [3] pursuant to the software. Software 147 aspects and aspects of the operating system, in whole or in part, may be read by the CPU processor, buffered within the processor, and then executed.

When the present system and method, or aspects thereof, are implemented in software, it should be noted that the software may be stored on any computer readable medium for use by or in connection with any computer related system or method. In the context of this document, a computer readable medium may include an electronic, magnetic, optical, or other physical device or means that may contain or may be configured to store a computer program for use by or in connection with a computer related system or method. Aspects of embodiments disclosed herein may be embodied in any computer-readable medium for use by or in connection with an instruction execution system, apparatus, or device, such as a computer-based system, processor-containing system, or other system that may be configured to fetch the instructions from the instruction execution system, apparatus, or device and execute the instructions. In the context of this document, a system “component” (such as, but not limited to a system server computer, system server controller, a mobile device forming a portion of the system, a computing device forming a portion of the system, a system-integrated kiosk, or the like) may comprise a computer-readable medium, wherein a “computer-readable medium” may comprise any means that can store, communicate, propagate, or transport the program for use by or in connection with the instruction executions of the system, apparatus, or portions thereof. The computer readable medium can be for example, but not limited to, an electronic, magnetic, optical, electromagnetic, infrared, or semiconductor system, apparatus, device, or propagation medium. More specific examples (a non-exhaustive list) of the computer readable medium may include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). It will be appreciated that computer-readable medium could be in paper form or associated with another suitable medium upon which the program is printed, as the program can be electronically captured, via, for instance, optical scanning of paper or other medium, then compiled, interpreted or otherwise processed in a suitable manner if necessary, and then stored in a computer memory.

For communication with the system server 128, kiosk [3] may be equipped with internet or other network connection means 101 for communicating information through the internet or other network 118 which might support the system. The connection means 101, may, for example, comprise various network communication equipment and circuitry. In some embodiments, the network communication equipment may include a network card such as an Ethernet card. Each of the kiosks 3 within the system network may be configured to use the TCP/IP protocol to communicate. It will be understood, however, that a variety of network protocols can be employed, such as IPX/SPX, Netware, PPP and others. It will also be appreciated by those having an ordinary skill in the art that while preferred embodiments may incorporate “broadband” connections to facilitate communications between kiosks [3] and other components of the system (e.g. computer 95), similar principles may be practiced using dialup connections, for example, using one or more standard modems. Wireless network connections are also contemplated, such as wireless Ethernet, satellite, infrared, optical, and radio frequency-based networks.

A central controller (not shown) provided to the centralized system server 128 may communicate with kiosk controllers (i.e., controllers within the kiosk CPU 97) via the internet or other network 118. The system server 128 is preferably located at a central station or office that is remote from the plurality of kiosks 3 and is maintained and updated regularly. The system server 128 may operate as the server for communicating over the network 118 between the plurality of kiosks 3. The controller associated with the system server 128 may receive communications and information from the kiosks 3, and may transmit communications and information to the kiosks 3. The controller associated with the system server 128 may receive communications and information from mobile devices 96 via a system application 147, and may transmit communications and information to the mobile devices 96 via the system application 147. The controller associated with the system server 128 may receive communications and information from computers 95 via a system website 127 or system application 147, and may transmit communications and information to computers 95 via the system website 127 or system application 147.

For example, when a transaction, such as a purchase of a redemption option is performed using a system kiosk 3, a system application 147, or a system website 127, transaction data such as payment data 10, purchase data 9, and/or redemption data 64 may then be transmitted from the respective system component 3, 147, 127 to the central controller of the server 128 via the network 118. It will be understood that central system servers 128 in general, such as the central system controller, may often be distributed. Accordingly, a plurality of central servers/controllers 128 may optionally be arranged in “load balanced” architecture to improve the speed and efficiency of the system network. To accomplish the implementation of multiple controllers, the controllers may be in communication with one or more routers/distributors.

The central controller associated with the system server 128 is may be in communication with a centralized system database 129. The system database 129 may store information regarding transactions made using various components 3, 19, 95, 96, 100, 108, 106, 127, 130, 147, of the system network. For example, the system database 129 may store data regarding an inventory of a plurality of redemption options (e.g., types 72 of redemption options) which are purchasable, tradable, redeemable, and/or otherwise useable at a plurality of vendors or entities 65. The central system database 129 may be configured to store sales, marketing, and third-party information regarding the number of sales, redemptions, or uses associated with various system components 3, 127, 147 (e.g., how many cards 19 were produced by a given system kiosk 3).

For example, the system database 129 may store information regarding the sales totals for a particular type 72 of redemption option (e.g., gift cards sales, total amount of money transfers, number of purchased coupons, number of passes or tickets purchased, etc.) for a particular kiosk 3, or it may store information regarding the sales totals in relation to a particular venue or location 2 or a particular vendor or entity. The system database 129 may store information 8 pertaining to a user 91, 92 and transaction information, such as user IDs, account numbers, PINs, issue dates 69, redemption dates (i.e., dates of use), historical transaction data 146, user profile 130 data, users' friends 145 interactions, and data associated with favorites 140 of a user or a user's friends 145. Some of this information may be stored, for example, in the form of metadata 90, within system kiosks 3 or in caches associated with a user's mobile device 96 or computing device 95. Such information may be accessed by third parties, such as marketing firms 94, financial institutions, social networks 93, online exchanges, online payment services, vendors or selling entities 65, etc. The system database 129 may store a master inventory list of all redemption options including their type 72, a list of all participating vendors or selling entities 65, a list of all users 91, 92 of the system, a list of all friends 145 of users of the system, a list of all third parties affiliated with the system, a list of information pertaining to location data associated with redemption options (e.g., where to redeem a particular redemption option, where to purchase a product, good or service), a list of user histories 146 (including card 19 uses, kiosk 3 uses, system application 147 uses, and system website 127 uses), a list of all transactions made using the system, a list of all gift senders and/or recipients—regardless of whether or not the senders and/or recipients have a system account/profile 130, and other relevant information pertaining to system uses and interactions therewith.

The database 129 is preferably a relational database, although it is anticipated that various other types of database architectures may be used without departing from the principles and scope. For example, in some non-limiting embodiments, the system database 129 may comprise one or more of an SQL database, an Access database, or an Oracle database, without limitation. The system database 129 may be capable of being shared between a plurality of computers or controllers (for example, computers or controllers which may be internal to the system and/or external to the system), wherein information, instructions, and executables may be capable of being transmitted via the internet or other network 118.

It will be understood by those having an ordinary skill in the art that a variety of methods exist for serving the information stored in system database 118. For example, in some embodiments, .net and Microsoft Reporting Services may be employed. Other technologies, such as CFML, ODBC, MySQL, and the like, may be employed without limitation. The computer or controller of the system server 128 and/or the system database 128 is preferably accessible by a user's 91, 92 computer 95 and/or mobile device 96. Access to the server 128 and/or database 128 may be facilitated by a user 91, 92 accessing the system website 127 or a system application 147, for example, an application downloadable from the system website 127 or mobile app store. The user's 91, 92 computer 95 and/or mobile device 96 will be understood as comprising hardware and software consistent with marketable computing devices, such as a display screen, user interface 106, means 117 for data input (such as a keypad, touch screen, speech recognition, tracking device, or stylus), and a microprocessor with memory.

In some preferred embodiments, computer 95 and/or mobile device 96 may comprise suitable internet browser 131 software, such as Firefox, Opera, Safari, Google Chrome, Internet Explorer, or equivalent internet browsing software. Using the system browser 131 software, a user 91, 92 of the system may, using their computer 95 or mobile device 96 access a web interface of the system website 127 through the server's 128 computer or controller. It is envisaged that the system server 128 may comprise web server software or one or more programs that serves content using the HTTP protocol (e.g., Google Web Server (GWS), Apache HTTP server, Oracle HTTP Server, IBM HTTP server, NaviServer, or Microsoft IIS). Alternatively, a variety of other web server software and web browser software solutions may be utilized to implement principles of certain embodiments without departing from the scope. Using the browser 131, a user 91, 92 may communicate with various components of the system server 128, such as the computer or controller, thereby allowing the user 91, 92 to log into a central command functionality of the system server 128 components and view and modify data stored in the system database 129. The browser 131, coupled with a system user interface 106 may enable a user to perform various system functions, tasks, and executions, which might affect the information stored on the system database 129 (e.g., user profile 130 information) and the behavior of various components 3, 127, 147 of the system. As shown in FIG. 12, one or more financial servers 122 (some of which may shared by nonaffiliated or affiliated financial institutions) may communicate with various components of the system via the internet or other network 118. As discussed throughout this specification, a variety of financial services exist for processing financial information (e.g., credit and/or debit-based card information, online payment account information, mobile digital wallets, cryptocurrency information) and conducting financial transactions via the Internet and other networks 118 without necessarily requiring customer interactions with corporations offering the financial services.

As shown most clearly in FIGS. 2 and 39, a user interface 106 of a kiosk 3 may include display means 109 (e.g., a touch screen), a card reader 110, data input means 117 (e.g., a keypad and/or touchpad presented on display means 109), and card dispensing device 111 having a transfer opening, wherein a card blank may be printed on, encoded, or otherwise customized based on user inputs 4. The card reader 110 is preferably designed in known fashion to read at least magnetically encoded membership, gift cards, points cards, rewards cards, loyalty cards, passes, coupon cards, and/or credit/debit cards for authorizing payment data 10, accessing payment data 10, manipulating payment data, withdrawing funds or credits, depositing funds or credits, using funds or credits, transferring funds or credits, changing types 72 of funds or credits, etc. In some embodiments, reader 110 may form all or a portion of payment receiving means 100 and/or all or a portion of payment dispensing means 119. In preferred embodiments, a system kiosk 3 may comprise all mechanisms, hardware, and software necessary to redeem any conceivable form of payment, including wireless payments from mobile digital wallets, wireless cryptocurrency payments, tap-and-go type payments, RFID-based payments, smart-chip card payments, and the like. Display means 109, user interface 106, data input means 117, etc. preferably permit consumers 91, 92 and/or maintenance personnel to communicate with a system kiosk 3 and/or a central office linked in electrical communication with the kiosk 3 (e.g., to indicate a problem or malfunctioning machine). Such components may permit consumers and/or maintenance personnel to enter appropriate inputs 4 such as commands or instructions which are necessary to carry out specific kiosk 3 tasks. It will be appreciated that an optional touch screen provided to a system kiosk 3 may include a monitor made with known technologies making it capable of being utilized as a user interface 106, for example, for entry of commands and inputs 4 designed to carry out kiosk 3 tasks.

Furthermore, it will be appreciated that additional user interface portions having additional or even identical user interface components could be incorporated within article dispensing machine, thereby providing redundancy and allowing a larger number of users 91, 92 to perform kiosk 3 interactions. For example, multiple components such as multiple displays 109, card readers 110, card dispensers 111, etc. could be incorporated on other panels of the housing 124 of the kiosk 3, or the kiosk 3 may be built with multiple user “units”, so that the kiosk may be used simultaneously by multiple consumers, translating into more efficiency in high traffic areas.

Kiosks 3 may contain one or more cameras 116 or other image capture devices which are positioned to photograph, record, recognize, track a user's eye movements, or otherwise capture an image of a user, particularly a user's face, and/or a user's surroundings adjacent a kiosk 3. Camera 116 may be used to capture

One process for authenticating transferred funds or credits from a first user 91 to a second user 92 is shown in FIGS. 25 and 26. As shown in FIG. 25, a recipient user 92 of the system may present a screen of a mobile device 96 towards the scanning means 102 or image capture means 116 provided on a kiosk 3 to initiate the redemption process via the user interface 106. As shown in FIG. 26, a recipient user 92 may access the transferred funds or credits from the first user 91 directly at a checkout or point-of-sale by presenting a screen of a mobile device 96 towards a clerk for scanning, or by swiping the mobile device 96 adjacent a contactless reader which is configured to communicate with the mobile device 96 (e.g., via NFC-protocols).

Authorization information 60, for example one or more security features such as a redemption password or passphrase may be necessary for a recipient user 92 to access redemption data 64 on their mobile device, for example, the password/passphrase may be one delivered separately to the recipient user 92 from the first user 91 (e.g., via phone call, text, email, etc.) outside of the system, or it may be an answer to a secret security question posed by the first user 91 for answering by the recipient user. The password or passphrase provided by the recipient user 92 to gain access to redemption data 64 may include authorization information 60 which is audio-based 7, or image based 6 as suggested in one or more of FIGS. 69-74. In some embodiments a card 19 produced by a kiosk 3 in the system may be both dispensed and received for reading by the kiosk 3 in the same receptacle, which may be, for example, an opening in a front panel of the kiosk 3 housing 124. Alternatively, different receptacles may be used for dispensing a newly issued card 19 and reading of existing cards 19. A user may insert existing cards 19 into the receptacle to charge the card (e.g., with provided funds or credits in the form of payment data 10), modify information pertaining to the card and associated system account, change data contained on the card. Alternatively, a card 19 may be scanned using scanning means 102, captured via camera 116, or otherwise physically or wirelessly read by payment receiving means 100 using EMV, RFID, and/or NFC protocols known in the art.

Once a system card 19 is inserted into or otherwise presented (within a proximity to) payment receiving means 100, reader means 110, scanning means 102, or image capture means 116, sensors within the means 100, 110, 102, 116 may be triggered and information associated with the system card 19 may be delivered to the CPU 97. For example, if the card 19 has thereon, image data 6 in the form of a barcode 79 or alphanumeric information (e.g., a code), the scanner 102 or image capture means 116 may illuminate the card 19 with infrared light (provided by illumination means not shown) and capture at least a portion of the image data 6 so that authentication information associated with the barcode 79 or alphanumeric information 89 can be read, converted to a digital file, sent to the CPU 97, and interpreted by the CPU 97. During capture of the image data, any number of images may be captured in rapid succession, or, in the case of a digital video camera, may take a continuous video of the card 19 as it is being read. The scanner 102 or image capture means 116 may be placed or otherwise configured in redundant configurations so as to capture images of the card 19 at various angles and/or to capture image data 6 on different portions of the card 19 (e.g., image data 6 placed on front or back portions of the card). The digital file(s) received by the CPU 97 may then be compared to a pre-programmed or “master” authentication code stored with the system database 129 to identify the system profile 130 associated with the card 19. If one or more of the digital file(s) match the master authentication code, the card 19 may be authenticated and CPU 97 may allow a user to access the system profile 130, or one or more additional security protocols 99 may take place to verify the identity of the person using the card 19. If the card cannot be properly read or may not match the pre-programmed or master authentication code, the CPU 97 may be programmed to prompt the user to “re-scan” the card 19 and/or it may be programmed attempt to request subsequent verification from the server 128. This process may repeat for a predetermined number of user tries or for a predetermined time period, until an attempt limit has been reached, at which point the user interface 106 may display a message to the user 91 that the card 19 could not be authenticated.

The aforementioned process may be practiced with a card accepting terminal (i.e., reader means 110) that draws a card into a slot or card receptacle for more accurate reading. In such instances, a rejected card 19 may be retained by the kiosk 3 and quarantined. The quarantined card 19 may be physically transferred to a separate holding area contained within the kiosk 3.

Alternatively, the card 19 maybe ejected from the reader means 110 and a message may be displayed to the user indicating that the card 19 could not be authenticated. A card sensor for detecting the presence of a card 19 inserted into a card accepting terminal may be provided. The sensor may be simple mechanical switch, a proximity sensor, a light bar, or any other suitable sensor known in the art for detecting presence. In some embodiments, the sensor may detect the presence of an inserted card 19 and activate an internal infrared light source 102a. The infrared light source 102a may be preferably turned on after the card 19 has been inserted into the card accepting terminal. The triggering of the sensor may directly activate the light source, or, the signal may be sent to the CPU 97, which activates the light source 102a. Alternatively, the light source could be activated by the initiation of the card insertion process by the consumer. For example, the user-selection of a “Insert Card” option via the user interface 106 may cause the CPU 97 to activate the infrared light source. Yet, alternatively, the light source 102a could constantly be on whenever the machine has power.

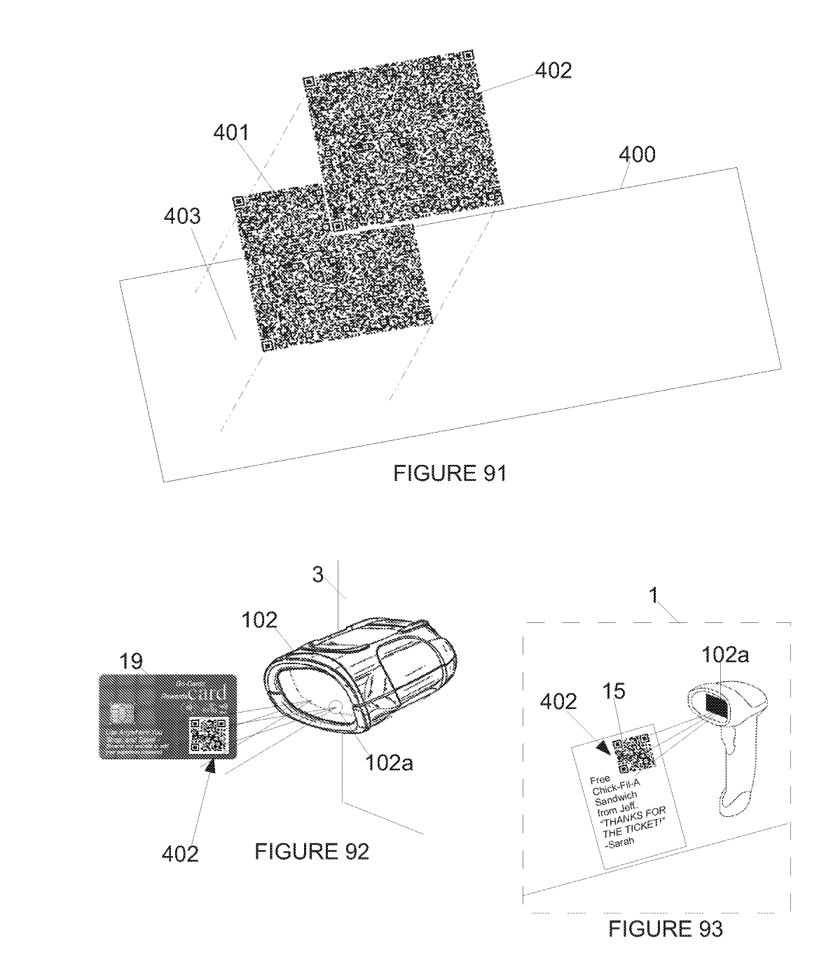

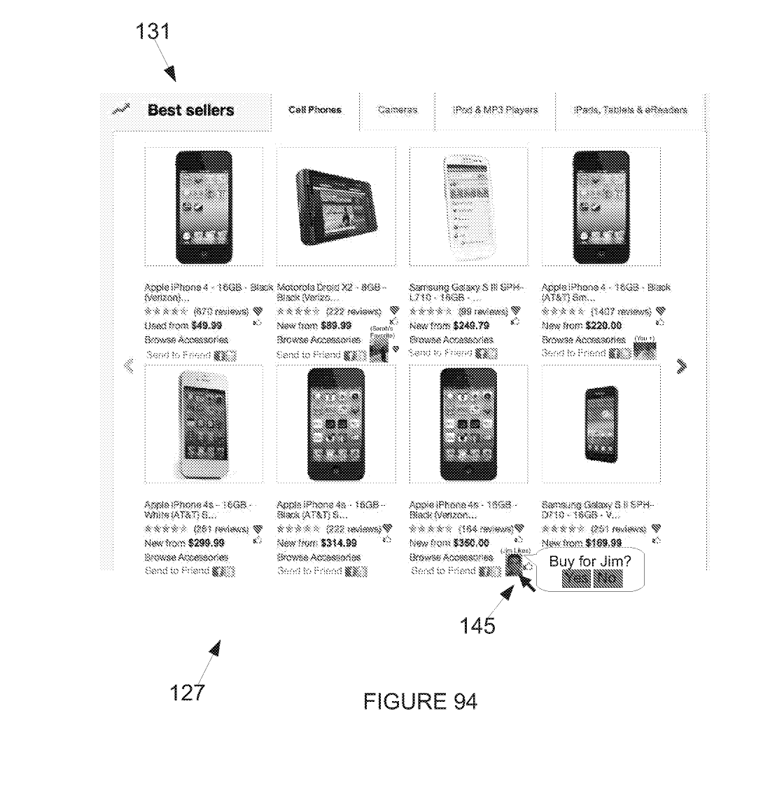

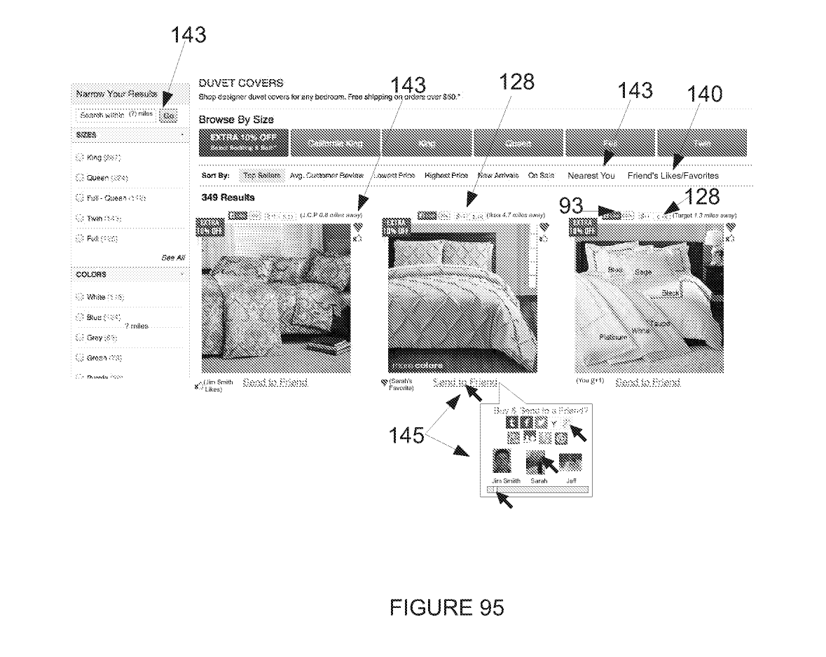

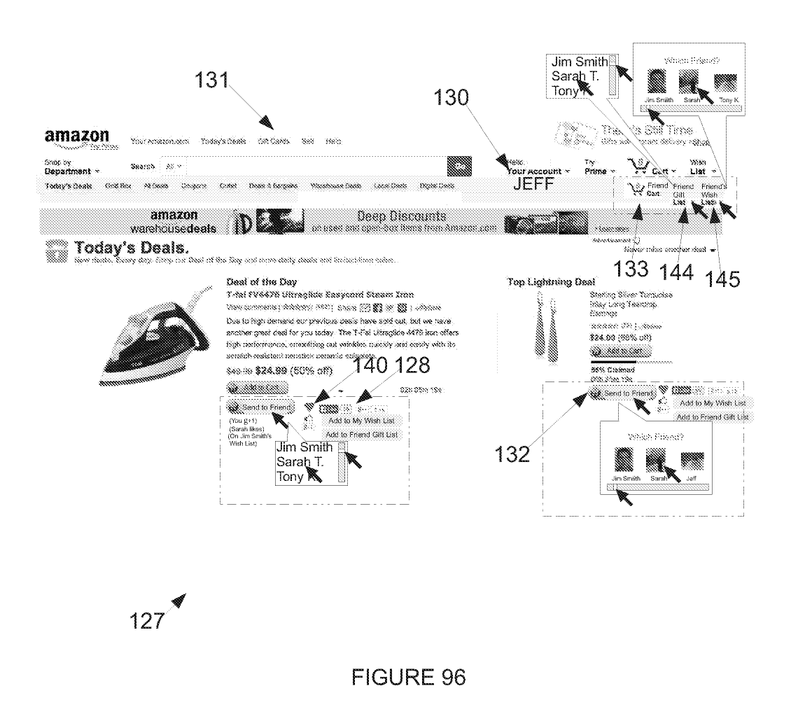

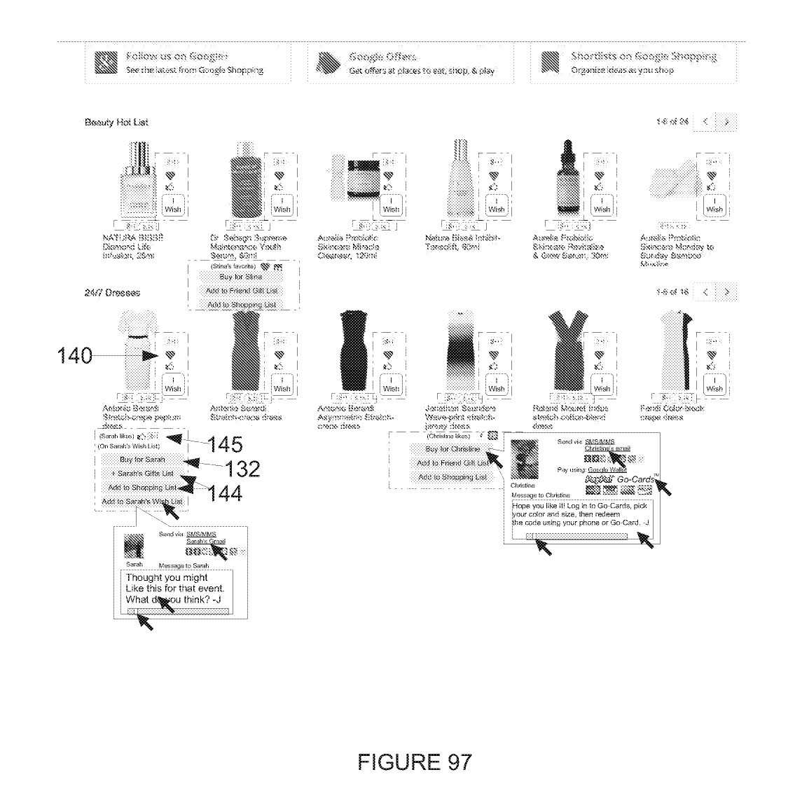

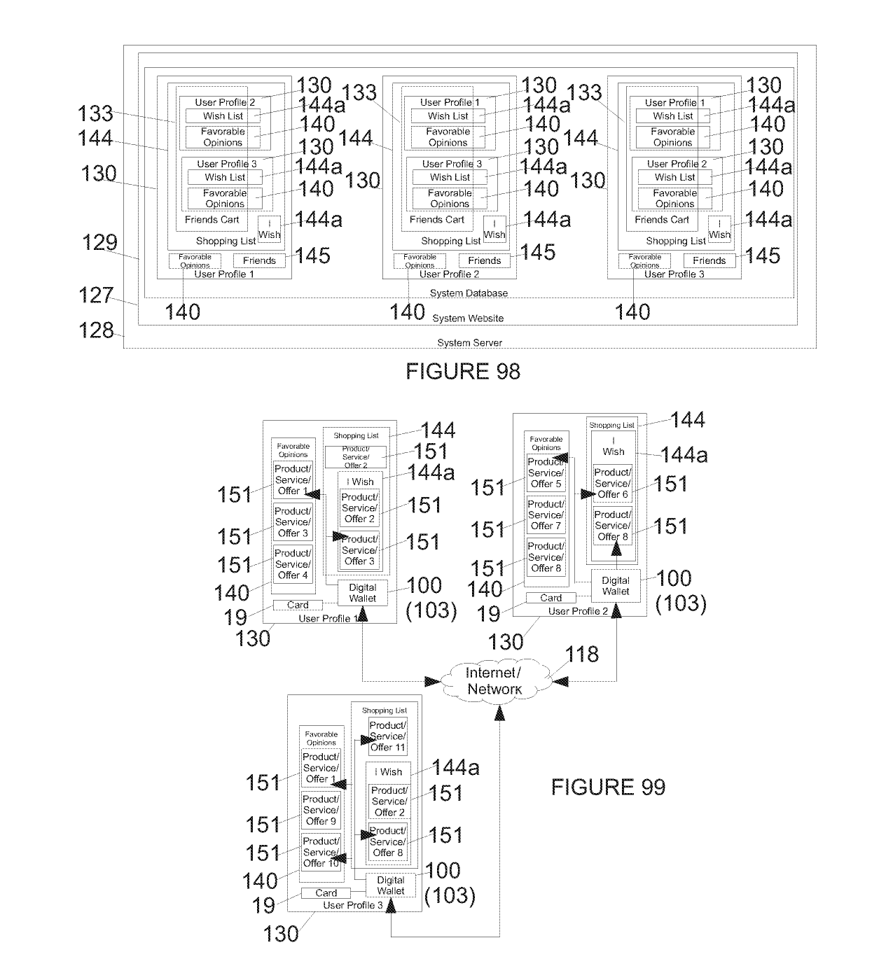

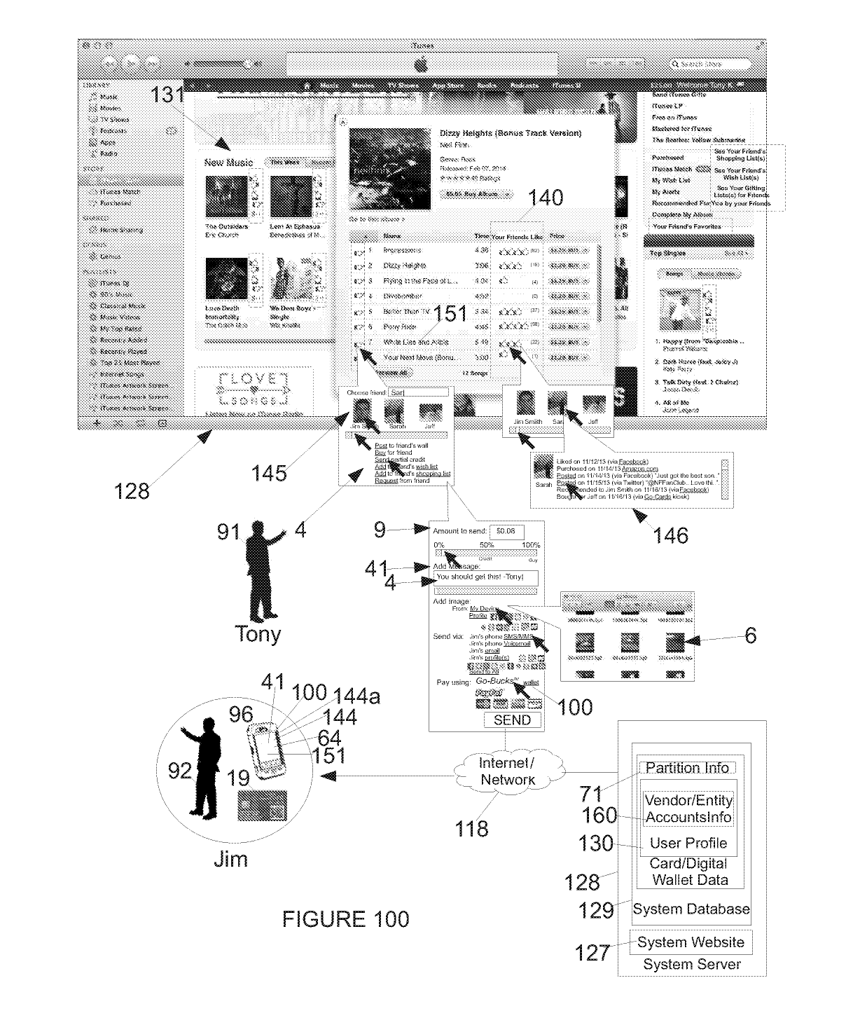

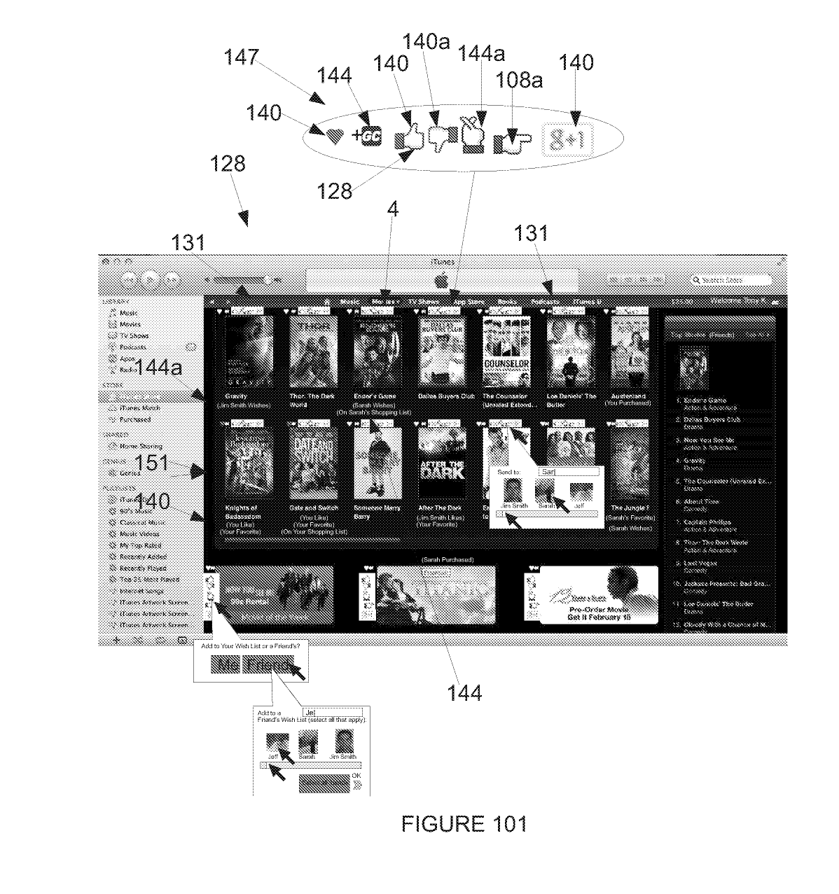

The light source 102a may be positioned to illuminate a first surface of the inserted card 19 with infrared light. The first surface may have a machine-readable authentication code, which is substantially visible when exposed to a first predetermined wavelength and forming a first layer 401 (see FIG. 91). For example, the machine-readable authentication code may be or may comprise a carbon containing ink, which, when exposed to infrared light, is visible. The authentication code may comprise, for example, one or more bar codes, data matrix codes, QR codes, or the like, which may represent one or more alpha-numeric sequences. However, the authentication code could be numerical or binary sequence or any other symbol or character or type of image data 6. The authentication code may be printed on one or more front or back surface portions of the card 19 in a plurality of locations to increase the ease of reading the authentication code and to allow the authentication code to be read even if one of the authentication codes is damaged or worn from heavy card 19 use. The authentication code may be printed to a transparent, translucent, or opaque label which printed by the kiosk 3 and is affixed to a surface of the card 19 by a user 91, 92. The authentication code may comprise toner imaged onto the card 19 via electron beam or ion deposition techniques, electrophotographic or electrographic methods or via ink jet. In this regard, a card may be used and re-used in different manners by a customer without having to print a new card 19. One or more second layers 402 may be applied over the first layer 402 in a medium that is substantially opaque in visible light, but is substantially transparent when exposed to the first predetermined wave-length of electromagnetic radiation. For example, the one or more second layers 402 may be or may comprise a substantially carbon free ink, which is applied overtop of and at least partially conceals the authentication code(s) contained within the first layer 401. The one or more second layers 402 may comprise solid geometric shapes that entirely or partially cover and conceal the authentication codes that form the first layer(s) 401. In some embodiments, a combination of first 401 and second 402 layers under visible or infrared light may collectively form machine-readable indicia in various wavelengths, for example, both the second 402 and/or first 401 layers may comprise various combinations of inks which are visible or invisible in certain wavelengths. One or more additional third and/or fourth layers may be provided having yet additional information which is machine readable at one or more other wavelengths. The one or more second layers 402 may be printed in black ink or another color of ink which is sufficiently opaque when viewed in white light. The substantially carbon free ink shapes may conceal all or portions of the authentication codes contained in the first layer 401 and prevent them from being viewed by the naked eye in white light or from being copied by a standard photocopying machine or captured by a cell phone camera. When the surface of the card 19 is exposed to infrared light, the carbon-containing authentication codes are visible through the at least one second layer 402, which is sufficiently transparent in infrared light. The at least one second layer 402 may be applied by litho or flexographic techniques, or by ink jet, electrophotographic or electrographic methods using printing means 104, or may be pre-applied to a number of sticker labels provided to a kiosk, which may be applied to a card or other article dispensed by a kiosk 3. The sticker labels may be dispensed for a user to place on any device, including an article dispensed by kiosk 3.

Compatible infrared reader devices having scanning means and infrared light emitting means 102a may be employed at various vendors or selling entities 65 and integrated with payment terminals. In this regard, cards 19 of the system may be utilized without worry of theft or misappropriation of the authorization code by individuals interacting with a user's card (e.g., restaurant servers, taxi cab drivers, bartenders, etc.). For example, a store clerk or retailer employee may scan an article comprising the first 401 and second 402 layers under visible light, and then scan the article comprising the first 401 and second 402 layers under infrared light, to confirm the authenticity of the article. Such scanning means may perform the two scans automatically in sequence.

In electronic situations, where a card 19 is not used to benefit from a purchased redemption option, and where a code or other image data 6 containing redemption data 64 is instead or additionally sent to a user's mobile device 96 in an electronic format (e.g., via a system application 147) the user 91, 92 may display a first image which is representative of the customer profile 130 or representative of the particular redemption option to a clerk or employee of a vendor or selling entity 65. Upon use/presentation of the image data 6 containing redemption data to the clerk or employee of the vendor or selling entity 65 (e.g., scanning a QR code which is displayed on the screen of the mobile device 96, with a scanner provided at a payment terminal of a entity 65), the system may send one or more subsequent forms of image data 6 or audio data 7 to the user's mobile device 96 in a machine or human-readable format to serve as an authentication code (i.e., in a similar manner as the secondary scanning of the first layer 401 under infrared lighting). In this regard, an electronic redemption (e.g., eGift certificate code, bar code, QR code, or other redemption data 64 stored in a visual mobile device 96 screen-displayable medium) may be secured from theft/misappropriation, since the authentication code is delivered at the point-of-sale. The authentication code may, in some embodiments, only be valid for a period of time which is sufficient to complete the transaction and redeem the initially presented redemption option. For example, the authentication code may expire after 15 or 30 seconds, or two minutes, without limitation. Such steps may be implemented to prevent a user from sending redemption data to another user's mobile device 96, computer 95, etc. Such security means, and other various technologies may be employed with various components of the systems, methods, and apparatus disclosed herein; for example, to ensure that a particular redemption option may only be redeemed from a particular (unique) device 96.

Alternatively, the card accepting terminal may comprise magnetic stripe reading capability to read data from a card 19 possessing a magnetic stripe 87. Alternatively, the scanning means 102, such as a laser barcode scanner may be used to read image data on the card 19 as conventionally done in a manner similar to which is shown in FIG. 25. Even more alternatively, a card 19 having a chip 86, RFID device 88, NFC-compatible device, or the like may be read wirelessly, for example, from an interrogator, transceiver, or other wireless reader means 110. In this regard, a user 91 may present the card 19 within a proximity of a kiosk 3 for user interactions and updates 142 to commence.

In some embodiments, a surface of the card 19 or a stored-value on the card 19 may include a first authentication code 16 thereon which represents unique user system account information or user data 8, and a second authorization code which may serve as an identifier of a type 72 of redemption, product or offering information 121, initial purchaser or donor of funds or credits, and/or entity information 65 such as entity accounts information 161, without limitation. In some instances, the first and/or second authentication codes 16 may be or may comprise a bar code 79 with an encoded serial number 121 uniquely assigned to a specific product/offering/service 151, or line (e.g., such as a brand encompassing many types of products 151), but may comprise a data matrix or alpha-numeric 89 sequence or the like, without limitation.

It should be understood that process/method step descriptions (e.g., 301′-335′), illustrations, or blocks (e.g., 201′-270′) shown in the figures are figurative in nature and that these process/method step descriptions or blocks represented in the figures represent modules, segments, or portions of code which include one or more executable instructions for implementing specific logical functions or steps in the process, and alternate implementations may be included within the scope of embodiments disclosed herein, in which functions may be executed out of order from that shown or discussed, including substantially concurrently or in reverse order, depending on the functionality involved, as would be understood by those having ordinary skill in the art.

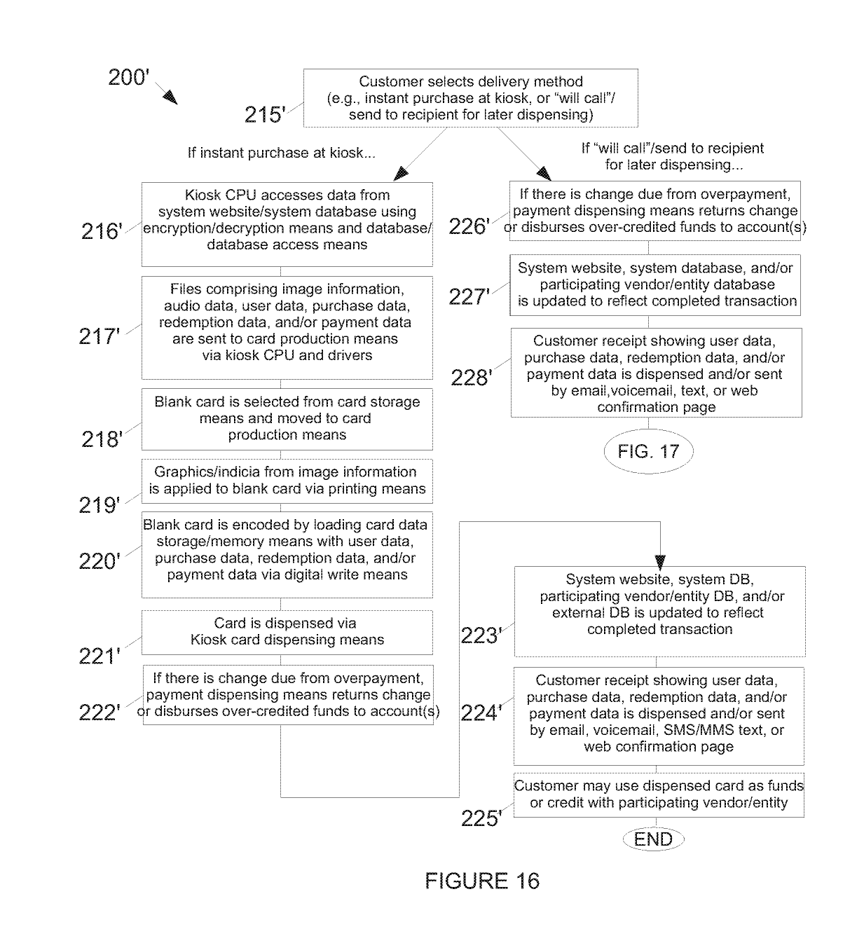

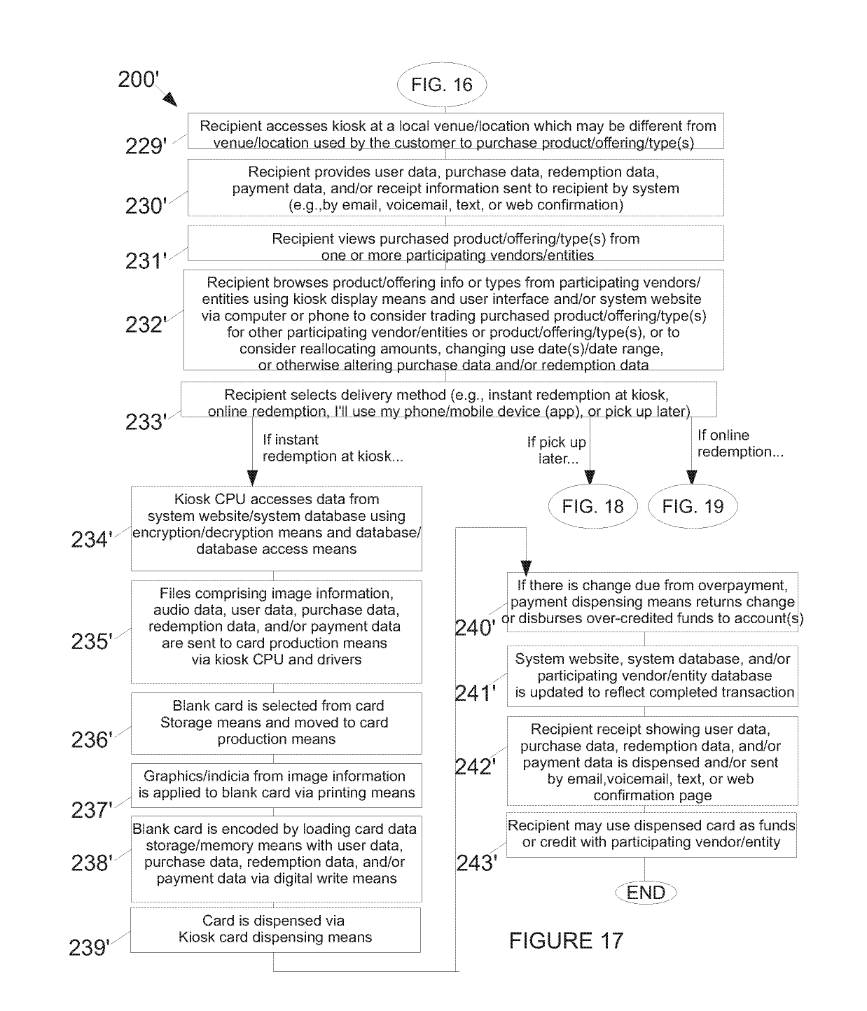

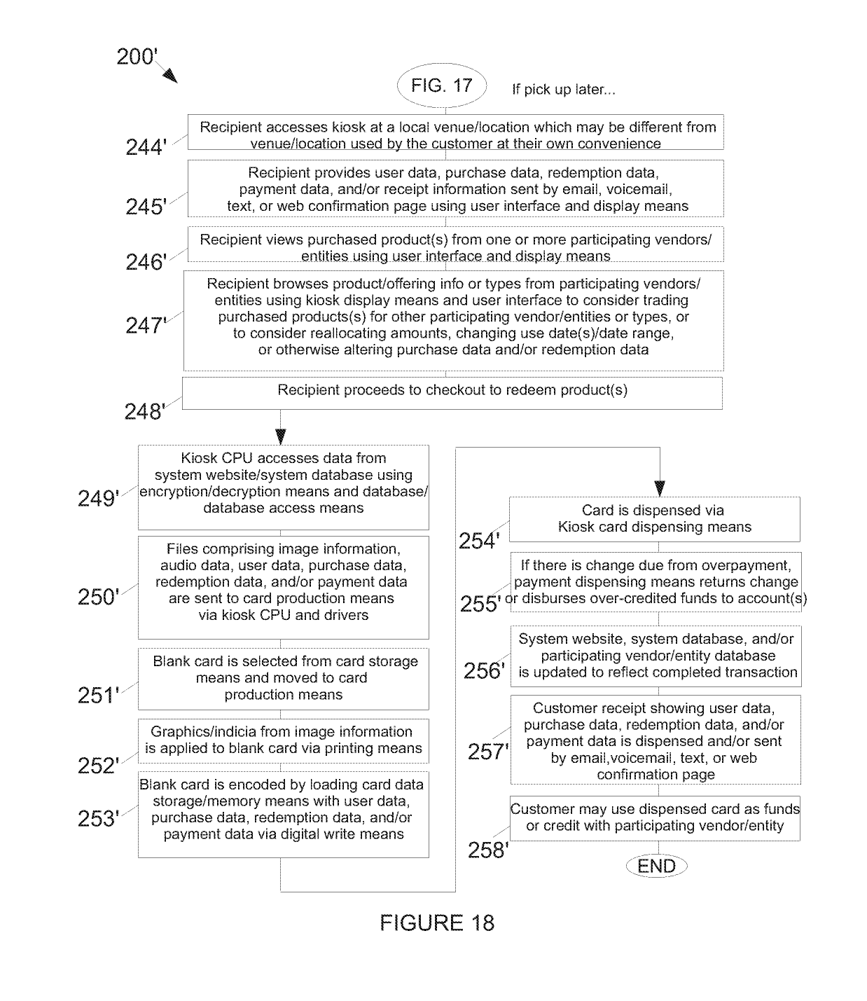

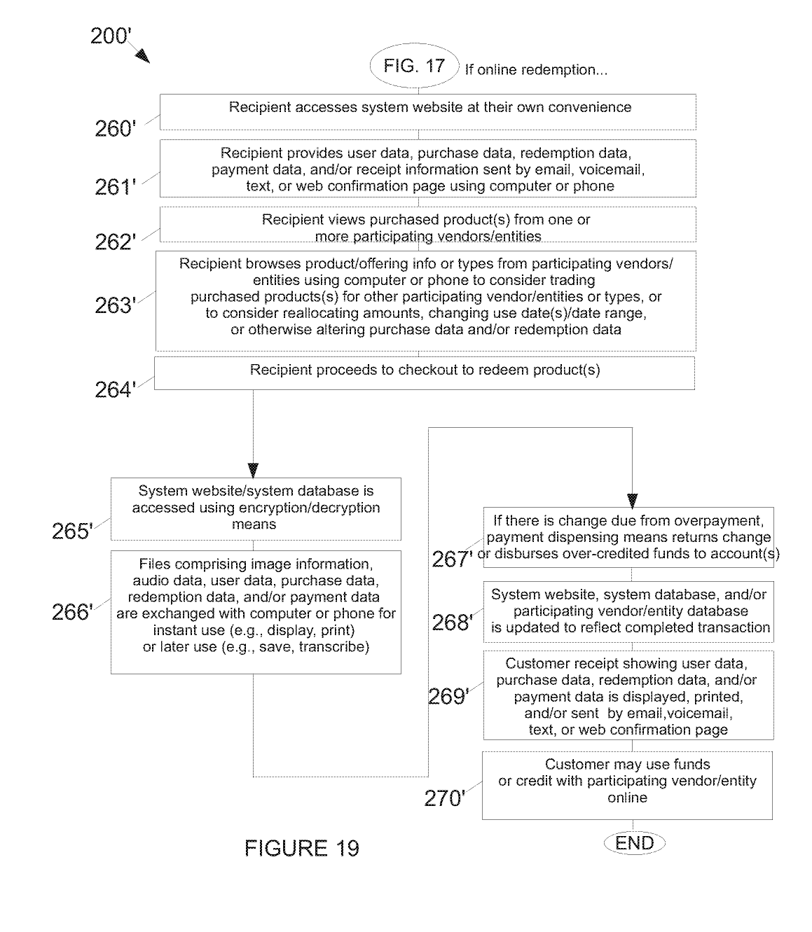

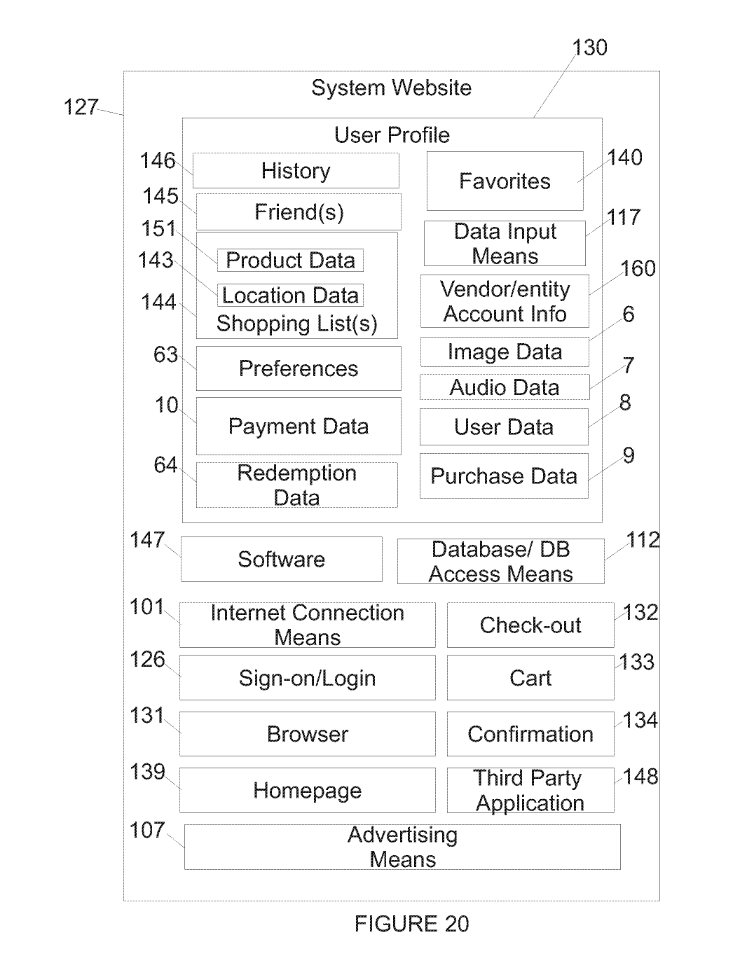

Although the exemplary non-limiting routines described herein (e.g., those routines shown in FIGS. 15-19, 21-38, 61-63b, 65a, and 65b) may have been discussed in particular orders, the various steps can be implemented in other orders, and various steps can be added and/or omitted from the routines without departing from the present technology. Accordingly, the routines described herein are not limited to the particular representative embodiments described above.

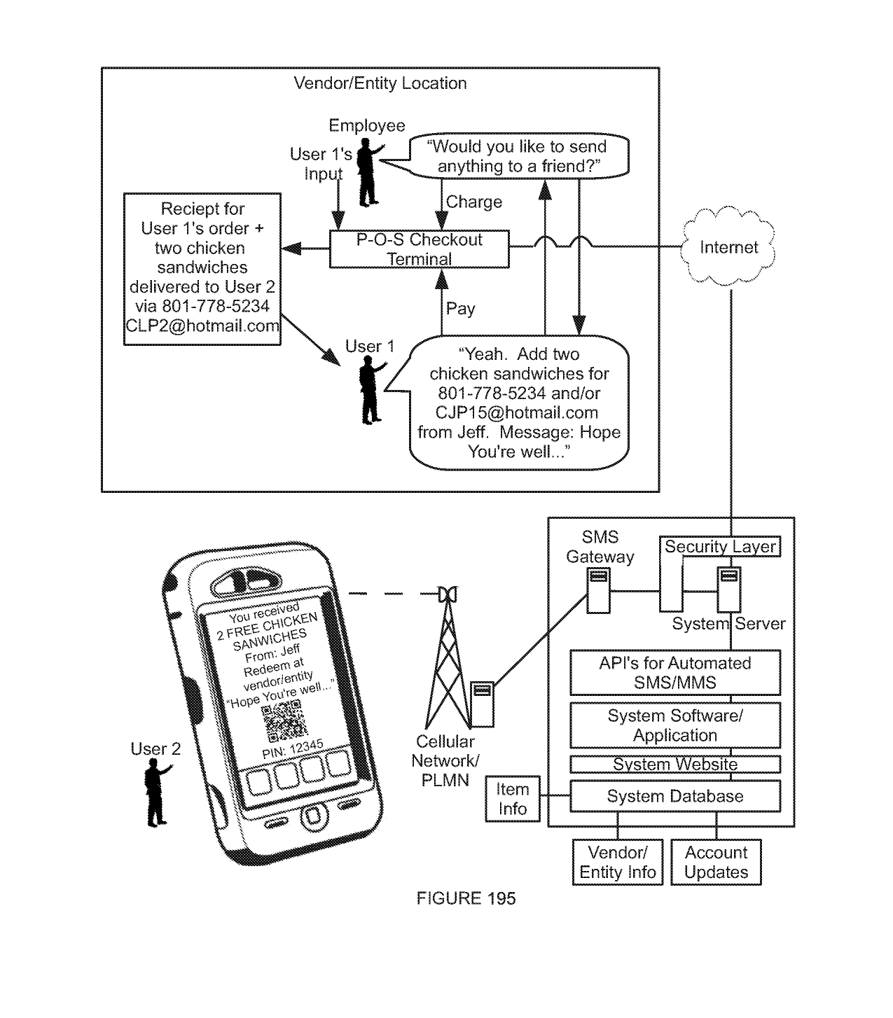

Turning to FIG. 195, according to some embodiments, a first user may shop at a participating entity location 2, such as a brick and mortar retail facility. The first user may, at the point of sale (P-O-S), pay for one or more items, products, goods, or services. During checkout, at the P-O-S checkout terminal, an employee of the participating entity 65 attending the P-O-S checkout terminal may ask the first user if he/she would like to send anything (e.g., an item, product, good, or service) to one or more other individuals, such as a contact, relative, coworker, or friend. Alternatively, or in combination with the aforementioned, a display within the participating entity location 2 (e.g., adjacent the P-O-S checkout terminal) offering the redemption option “Ask us if you would like to send store credit or an item to a friend”, or the like, may be provided. While not expressly shown, it is also envisaged that the employee may additionally or alternatively ask the first user if he/she would like to send participating entity 65 store-accepted credit to a contact, friend, coworker, or relative. The first user may respectfully decline the offer, or accept the employee's offer and provide instructions to the employee regarding the same.

For example, as shown, if the participating entity 65 is a restaurant establishment (e.g., a fast food chain or franchise location), the first user may request that one or more food and/or beverage items or “value meals” be sent to one or more particular recipients users. The first user may, for example, indicate the particular items, products, goods, or services (e.g., in the depicted embodiment, a couple of chicken sandwiches) which are desired to be gifted, and the first user may indicate to whom the indicated particular items, products, goods, or services are to be delivered electronically to. The first user may provide one or more respective recipient electronic addresses, such as one or more of a mobile phone number, email address, social media profile number and/or social media address (e.g., “Facebook profile number 69123615” or “Twitter profile username @chuckCLP2”), online profile username or screen name (e.g., Google, Yahoo, Skype, AOL, MSN, WeChat, Facebook), and/or other electronic address which may correspond to the desired recipient(s) of the purchased items, products, goods, or services to be gifted. In some embodiments, the first user may redundantly provide more than one electronic address of a single recipient, wherein similar redemption data 64 may be delivered to each of the more than one electronic address of a single recipient. In some embodiments, the first user may gift multiple items for a recipient (as shown), wherein the first user may be charged at the time of the request, and pay in a conventional manner using the P-O-S checkout terminal and/or interactions with the employee. In some embodiments, the first user may send to multiple recipients in a single transaction, without limitation.

In the particular example shown in FIG. 195, a first user may provide user data 8 (e.g., a mobile phone number and/or electronic mail address) of a recipient and may indicate two items (e.g., two chicken sandwiches) to be delivered to the recipient associated with the mobile phone number and/or electronic mail address. The employee may enter the information into the payment system or payment receiving means 100 associated with the P-O-S payment terminal, and the first user may pay for all items, products, goods, or services associated with the transaction—including the electronically gifted, but not physically received items. Separate or multiple transactions may be made by the first user; however, embodiments may conveniently allow the first user's purchases and electronic gifting purchases to be made during the same transaction (e.g., wherein some or all purchased and electronically gifted items, products, goods, or services are provided on one receipt 20). The receipt may separately list or otherwise indicate gifted items and user data 8, such as recipient info (e.g., electronic addresses), in addition to any other items, products, goods, or services personally purchased by the first user for the first user, and received by the first user. In the embodiment shown, the first user is not provided with the gifted items, products, goods, or services. Rather, an electronic (eGift) certificate, voucher, coupon, store credit, or other participating entity 65-recognized funds or credits is electronically delivered to the recipient, via the P-O-S checkout terminal provided with software which is configured to communicate the information to a system-integrated database 129 on a system-integrated server 128. According to some embodiments, a separate receipt 20 may be given to the first user (e.g., one receipt for received items, products, goods, or services, and another receipt 20 for gifted items, products, goods, or services). The first user may receive any non-gifted (personally-purchased) items, products, goods, or services, and the transaction may be completed thereafter. Depending on the terms and conditions associated with the system (and/or the participating entity 65 employing the inventive features and concepts), the participating entity 65 may, in some embodiments, optionally send one or more follow-up communications (which may include one or more deals, offers, coupons, advertisements, and/or other promotions) to the recipient's contact information provided by the first user to the system as an input 4. Means for the recipient of the electronically gifted items, products, goods, or services, to “opt-out” of the one or more follow-up communications may be provided in the one or more follow-up communications (e.g., “if you do not wish to be on our eClub mailing list, please reply with <insert system-based instructions>”, wherein system-based instructions may comprise a command to be included in an electronic message communication to a system address). In some embodiments, the system address may comprise the system address delivering the one or more follow-up communications.

It should be understood, and it is anticipated, that while preferred embodiments may involve electronic delivery of gifted items, a physical mailing address of the recipient may be provided, and funds or credits (or physical items, products, goods, or services purchased) may not be received by the first user, but instead, be delivered to the recipient by way of postal service, delivery service, and/or other “snail” mail system.

The P-O-S checkout terminal or participating entity payment system/payment receiving means 100 may be connected to a network 118, such as the internet or a wireless network (e.g., Wi-Fi, WAP, cellular tower network, or satellite-based network) which may communicate with a system server 128 (as shown) and system database 129. According to some embodiments, the system server 128 may be controlled, managed, and/or maintained by a third party which is separate from or otherwise non-affiliated with the participating entity 65. According to some embodiments, the system server 128 may be controlled, managed, and/or maintained, for example, by the participating entity's 65 own personnel. According to some embodiments, a legal entity of the system (e.g., the inventor/applicant) may control, manage, and/or maintain the system server 128 with its own personnel.

API's for automated SMS/MMS messaging protocols may be utilized in concert with an SMS gateway to deliver the electronic (eGift) certificate(s), voucher(s), coupon(s), store credit(s) or other vendor/selling entity-recognized funds or credits to the recipient(s) indicated by the first user and paid for by the first user. As shown, the delivery of redemption data 64 may be made through a cellular network (which may be facilitated by Internet and/or Intranet data communication means) and received by the recipient via a text message, email, social media website, mobile application, client software, etc. A system website 127 (or website affiliated with the vendor/selling entity 65) may be accessed and utilized to check funds or credits, to learn more about how the system works, and/or how to redeem received gifts (e.g., in the form of redemption info 64), without limitation. Preferably, all information necessary to redeem the electronic gift may be provided to the recipient in a single message delivery, which may or may not include instructions to visit the system website or one or more hyperlinks for further instructions. In this regard, the number of steps for the user may be minimized. An electronic message may include instructions on how to redeem the electronically gifted funds, credits, items, products, goods, or services. For example, in some embodiments, an electronic message may include a PIN or authorization code and may include instructions to present the PIN or authorization code upon redemption at a participating entity location. In some embodiments, one or more time-based PINs may be delivered from the system (e.g., via SMS messaging protocol) upon the use (voiding/redemption) of redemption information 64 contained within the electronic message, wherein the one or more time-based PINs may be delivered to the recipient (e.g., the user possessing the redemption information 64 and wishing to use the redemption information in exchange for items, products, goods, or services) in order to verify, authenticate, and complete a transaction. In some embodiments, other protocols may be used to deliver one or more time-based PINs in an electronic message, for example, MMS protocols (e.g., for inclusion of image-based 6 or audio-based 7 time-based PINs, which may comprise machine-readable indicia and/or acoustic signals, without limitation), mobile messaging protocols, instant messaging protocols, email protocols, cellular phone call protocols (e.g., wherein a system autodialer may call back a recipient to provide the one or more time-based PINs), social media platform protocols, or a web-based communication (e.g., from a system application 147 stored on the recipient's mobile device 96, or from a live video chat which may play and/or display the one or more time-based PINs), without limitation. In some embodiments, one or more time-based PINs may be electronically communicated to a redeeming participating entity 65 via system components (e.g., system server 128) in a similar manner using a similar or different protocol/platform. In some embodiments, the same one or more time-based PINs may be delivered to both the recipient and the respective participating entity 65; wherein each of the respective recipient and participating entity 65 may receive one or more time-based PINs on the same platform/protocol, or wherein each of the respective recipient and participating entity 65 may receive one or more time-based PINs via different platforms/protocols. In some embodiments, delivery of the one or more time-based PINs may be achieved, for example, by a recipient of redemption information 64 wishing to use the redemption information 64 in the near future, providing a command to the system via an electronic communication (e.g., an electronic message containing the redemption information 64 and a system command, such as “void” or the like to a system electronic address; or, an electronic message containing redemption information 64 and the participating entity's 65 electronic address to a system address; or, an electronic message containing redemption information 64 and a system command, such as “regift” or the like (e.g., “gift” or “send”) and the participating entity's 65 electronic address to a system electronic address, without limitation). According to some embodiments, system-integrated software 147 may determine from a system database 129 if redemption information 64 communicated to the system electronic address is valid, and if so, system software 147 may provide the appropriate one or more time-based PINs to the recipient and/or the respective participating entity 65 as needed to verify, authenticate, and complete the transaction. In some embodiments, delivery of the one or more time-based PINs may be achieved by a recipient or employee typing redemption information 64 into a keypad on the P-O-S checkout terminal, or to a kiosk 3 provided adjacent to the P-O-S checkout terminal which may be operably connected to and may communicate with the P-O-S checkout terminal. In some embodiments, delivery of the one or more time-based PINs may be achieved by a recipient or employee speaking redemption information 64 into a speech-to-text configured P-O-S checkout terminal, or to a kiosk 3 configured with speech-to-text capability provided adjacent to the P-O-S checkout terminal which may be operably connected to and may communicate with the P-O-S checkout terminal. In some embodiments, the P-O-S checkout terminal (and/or kiosk 3 provided thereto) may comprise audio input means, and/or reader means, with appropriate software and processer, which may be used to receive and process audio-based and/or image-based time-based PINs delivered from the system to a recipient and/or to a participating entity 65.

In some embodiments, an electronic message may include a machine-readable image (e.g., 1D or 2D barcode, data matrix code, QR code) or an audio file (e.g., containing a digitone) and may include instructions in the same electronic message or in a subsequent electronic message regarding how to present the image or play the audio at the time of redemption with a participating entity 65 (including online, wherein a computer 95 camera/microphone or mobile device 96 camera/microphone may be used to receive such user inputs 4, and wherein system software 147 provided to the respective computer 95 or mobile device 96 may process the inputs and present it into a field of a webpage of a website, for example, during checkout on a checkout page, without limitation). In some embodiments, an electronic message may include information 64 about the particular funds, credits, items, products, goods, or services purchased by a first user which may be used/redeemed by the recipient. In some embodiments, the electronic message may include an optional personal greeting (if provided by the first user at the time of gifting). The optional personal greeting may, for example, be entered by the P-O-S checkout terminal employee upon the first user's request, or the optional personal greeting may, for example, be provided to a simple user interface 106 such as a touch screen with a touchpad provided adjacent the P-O-S checkout terminal, which may be utilized by the first user to enter recipient information and the optional personal greeting themselves. In some embodiments, the electronic message delivered to the recipient containing pre-paid redemption information 64 may include user data 8, such as first user (i.e., “gifter”) information, such as a name, phone number, and/or email address of the first user, in order to notify the recipient who the electronic gift is from. In some embodiments, the delivered electronic message may comprise one or more redemption numbers or codes which may be associated with or contained within a database 129 table containing information about the gifted funds or credits, wherein the delivered electronic message may comprise similar information about the gifted funds or credits. According to some non-limiting embodiments, participating redeeming entities 65 which agree to accept system redemption numbers or codes may be provided with an electronic key FOB (e.g., of the RSA SecurID-type) or other type of time-based token, code, or key generator (e.g., a system application) provided by the system, wherein when a recipient uses/redeems redemption information 64 (e.g., in a manner consistent with the above), the recipient's system-received time-based PIN (e.g., a time-based SMS pass code) should match the FOB or token generator-provided pass code, in order to validate/authorize a transaction. In this regard, redemption information 64 may be impractical or have little value for others who might be able to misappropriate the redemption information 64 (e.g., from man-in-middle attacks), but do not actually physically possess the mobile device 96 comprising the electronic address associated with the redemption information 64 that may receive the time-based PIN communication during use/redeeming of the redemption information 64. In some embodiments, other system components may be used for added security, such as one or more cards 19, which may be required to be used at the time of use of redemption information 64 at a participating entity's physical or online location 2.

According to some embodiments, a system-integrated database 129 may contain one or more redemption codes associated with: participating entity information (e.g., regarding a transaction date, transaction time, transaction location, transacting employee information, store number, participating entity location ID), purchaser (i.e., first user) information (e.g., name, mobile device/phone number, email, profile number, profile name, screen name, userID, or electronic address, IP address, physical address, etc.), “item info” regarding items/products/goods/services purchased (including store credit), recipient information (e.g., name, mobile device/phone number, email, profile number, profile name, screen name, userID, or electronic address, IP address, physical address, etc.), and/or the like, as necessary or appropriate. In some embodiments, if the first user and/or recipient has an account with the system and/or an account with the particular participating entity 65 redeeming the one or more redemption codes, then certain updates to the respective account(s) may be made to reflect metadata 90, for example, metadata 90 obtained from purchases, gifting functions, changes in status of the one or more redemption codes, and/or redemptions/uses of the one or more redemption codes, without limitation.

In some embodiments, upon redemption of a received electronic gift at a participating entity location, a recipient may receive a subsequent confirmation SMS/MMS/mobile message, instant message, email, voicemail, alert on a mobile application, or the like which may contain information to be presented to the employee or P-O-S checkout terminal at the time of redemption. In this regard, an employee may be able to, according to some embodiments, instantly verify the recipient's identity and/or that the redemption info being provided matches the same recipient's electronic address (e.g., mobile device 96 number).

In some embodiments, received electronic gifts may be electronically stored on a recipient's mobile device 96, and/or merged with a recipient's digital wallet and used as a “virtual” gift card. In some embodiments, users with smart phones may copy all redemption messages sent via email or text to a single file or document for later use. In some embodiments, some or all received electronic gifts may be associated with the recipient's system card 19, wherein the recipient may use the card 19 at a P-O-S checkout terminal in a more conventional manner, wherein system software 147 provided to the P-O-S terminal may access a system database 129, may identify a complete listing of all available items, products, goods, or services which may be redeemed using the recipient's system card 19, may determine which items, products, goods, or services are to be actually exchanged for redemption information (e.g., by indexing through a list of scanned or entered items, products, goods, or services in the recipient's “cart” or by indexing through a list of ordered items, products, goods, or services), may automatically void redemption information 64 matching those items, products, goods, or services which are to be actually exchanged for redemption information (e.g., by changing a status of the matching redemption information 64 to an “inactive” or “void” status, and/or importing the matching redemption information 64 to a “used” table, or the like), may automatically credit a system account of the participating entity 65 providing the P-O-S checkout terminal in the amount or an amount slightly less than an equivalent value of the matching redemption information 64. It should be understood that the step of automatically crediting a system account of the participating entity 65 providing the P-O-S checkout terminal may alternatively comprise direct depositing a financial institution 163 account of the participating entity 65 automatically, via the system's financial institution 163 server 122 software. In some embodiments, the direct depositing step may occur after a total aggregated value of redemption information 64 exchanged for actual items, products, goods, or services made exceeds a predetermined amount. In some embodiments, the direct depositing step may occur after a system account balance of a participating entity 65 exceeds a predetermined amount. In some embodiments, the direct depositing step may occur every time a participating entity 65 exchanges redemption information 64 provided by a recipient for actual items, products, goods, or services. It should further be understood that the step of automatically crediting a system account of the participating entity 65 providing the P-O-S checkout terminal may further comprise sending one or more checks to the participating entity 65 or to the corporate headquarters of the participating entity 65, wherein the one or more checks may include metadata 90 or other information (e.g., particular store number) and may be made in an amount(s) which is less than the system account balance of the participating entity 65, without limitation.

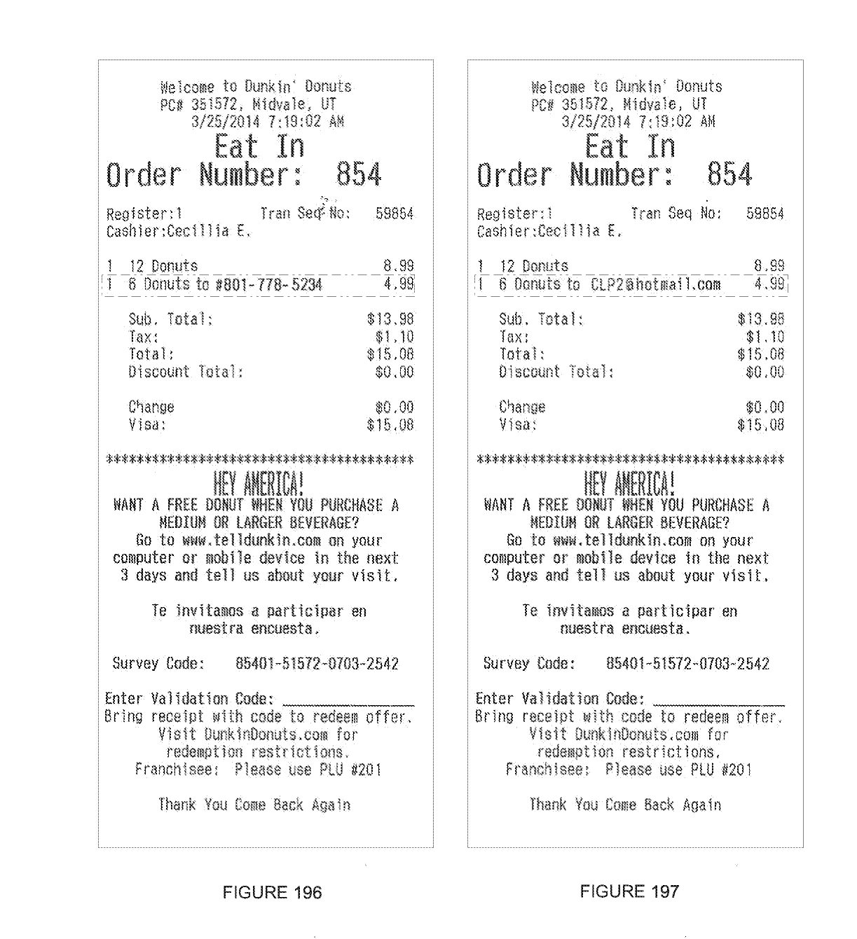

FIG. 196 suggests one possible non-limiting example of a receipt 20 showing a single transaction wherein a first user purchases one dozen donuts for himself/herself, and electronically gifts a half dozen donuts to a friend. In the non-limiting embodiment shown, during checkout, the first user provided the store employee “Cecillia E.” with user data 8 (i.e., recipient's mobile phone number “801-778-5234”) as a customer input 4, and stated that he/she wished to pay for and gift six donuts to that mobile phone number. Moreover, in the particular non-limiting embodiment shown, the first user paid for all items with a VISA credit card, but only physically received twelve donuts after the transaction was completed. A pre-paid gift voucher for six donuts was delivered via SMS, MMS, mobile email, or mobile messaging to “801-778-5234”, depending on the preferred software and/or integrated third party services (e.g., gateway). While not expressly shown in FIG. 196, it is envisaged that the first user could have conceivably sent one or more additional donuts, bagels coffees, snacks, or store credit (e.g., Dunkin' Donuts gift card credit) to the recipient's mobile phone number “801-778-5234”. It is further envisaged that the first user could have conceivably sent one or more donuts, coffees, snacks, or store credit to other recipients having other mobile phone numbers. In such cases, the additional items and/or intended recipients may be separately listed in a fashion similar to what is shown.

In other possible non-limiting embodiments, a receipt 20 may show information pertaining to a single transaction wherein a first user purchases items for himself/herself, and electronically gifts one or more other items for a friend. During checkout, the first user may provide the store employee a recipient's electronic address and may state that he/she wishes to pay for and gift one or more items to that friend's (e.g., recipient's) electronic address. The first user may pay for all items with a gift card, credit card, debit card, or cash as conventionally done, but may not receive certain gifted items after the transaction is completed. A pre-paid gift voucher for the one or more gifted items may then be electronically delivered to the electronic address via a compatible communications protocol (e.g., voicemail, phone call, SMS, MMS, or mobile messaging to the recipient's mobile number if a recipient phone number is provided, or via an email if a recipient email address is provided, or via social media post/direct message if a recipient social media ID or screen name is provided, etc.). It is envisaged that the first user could send one or multiple items, products, goods, or services and/or an amount of store credit to a recipient's electronic address, without limitation. It is further envisaged that the first user may send one or more items, products, goods, or services (and/or amounts of store credit) to one or more other recipients having other electronic addresses. In such cases, the additional items and/or intended recipients may be separately listed on the receipt 20 (along with their respective electronic addresses). In some embodiments, separate receipts 20 may be provided for each recipient-based transaction. In this regard, in some embodiments, the first user, participating entity 65, and system may have a record of a transaction(s) in the event the system fails and/or in the event that information is entered into the system incorrectly. It should be understood that though the embodiments shown in FIGS. 196 and 197 suggest a first user making a purchase of items, products, goods, or services for himself/herself, a first user need not necessarily purchase items, products, goods, or services for himself/herself, to employ the inventive gifting concepts disclosed. In some embodiments, special discounts for electronically gifted merchandise may be applied by system software 147 to entice customers to participate in the inventive electronic gifting concepts disclosed herein, without limitation.

FIG. 197 suggests one possible non-limiting embodiment of a receipt showing a single transaction wherein a first user purchases twelve donuts for himself/herself, and electronically gifts a half dozen donuts to a friend. In the particular embodiment shown, during checkout, the first user provided the store employee “Cecillia E.” with an intended recipient's email address “CLP2@hotmail.com” and stated that he/she wished to pay for and gift six donuts to that email address. The first user paid for all items with a VISA credit card, but only received twelve donuts after the transaction was completed. A pre-paid gift voucher for six donuts was electronically delivered via email to “CLP2@hotmail.com” by system-integrated software provided to the P-O-S checkout terminal and/or the system server 128. While not expressly shown, it is envisaged that the first user could have conceivably sent one or more additional donuts, bagels coffees, snacks, or store credit to the recipient's email address “CLP2@hotmail.com”. It is further envisaged that the first user could have sent one or more donuts, coffees, snacks, and/or store credit to one or more other recipients having other email addresses or other types of electronic addresses. In such cases, the additional goods/services and/or intended recipients may be separately listed in a fashion similar to what is shown.

While the particular embodiments shown in FIGS. 196 and 197 show some preferred embodiments (i.e., which use email addresses and mobile phone numbers), receipts 20 may show social media profile numbers (e.g., “62178614” for Facebook), screen names, userID's, Twitter address (e.g., “@kaitlyn85”), Twitter hashtags (used as item/product/good/service identifier numbers), and/or the like, without limitation.

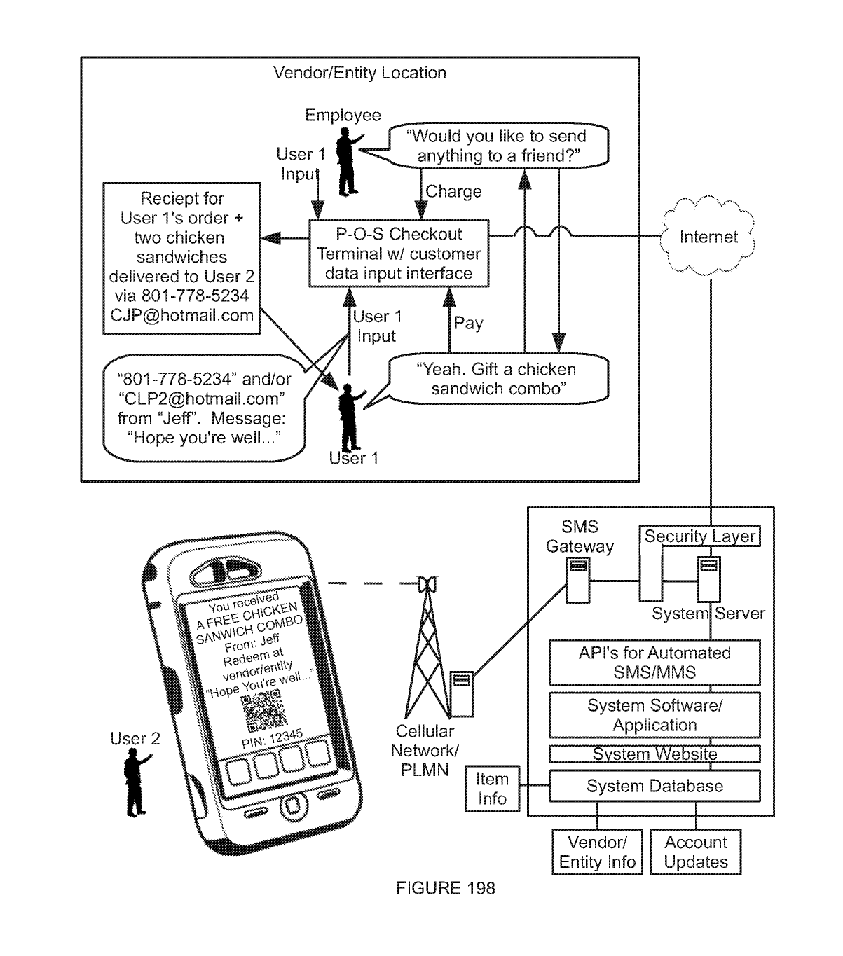

Turning now to FIG. 198, a first user may, as shown and discussed above for FIGS. 196 and 197, similarly gift an item at a vendor/selling entity location 2; wherein instead of providing the employee with instructions and/or inputs 4 to enter into the cash register/payment terminal, the first user may personally enter information (e.g., user data 8) using a user interface 106 configured for receiving inputs 4 from the first user. The user interface may take many forms, and may comprise, for instance, a tablet, a mobile device, a touchpad, a touch screen, a keyboard, or other conceivable user interface capable of receiving alphanumeric input information which may be provided for access by the first user (e.g., near a checkout counter). In some embodiments, the user interface 106 may be configured to accept and/or interpret verbal commands from the first user, such as speech-to-text inputs which may be processed by a processer and system-integrated software 147; for example, to facilitate processing electronic gifting functions for one or more recipients by saying, rather than manually entering recipient electronic address information. In some embodiments, the user interface 106 may be configured with means for receiving and processing image data 6 and/or audio data 7 into a usable form, for example, to conveniently import user data 8 pertaining to one or more contacts stored in a contacts list of a mobile device 96, to the P-O-S checkout terminal, for quickly processing electronic gifting functions for one or more recipients (e.g., a first user may create various “gifting lists” using a system application 147 and store them into a machine-readable format such as an interpretable audio-based data file or machine-readable indicia). According to some embodiments, the user interface 106 may comprise a kiosk 3, such as a mini kiosk, without limitation. In some embodiments, while not shown, if the terminal and first user's mobile device is configured with near field communication (NFC) or equivalent wireless technology (e.g., Android “beam”) capability, the first user may, using a system mobile application, enter recipient information or select a mobile contact on their own mobile device, and tap or swipe the first user's mobile device adjacent the checkout terminal. Alternatively, if the terminal and first user's mobile device is configured with near field communication (NFC) or equivalent wireless technology (e.g., Android “beam”) capability, the first user may, using a system mobile application 147, select one or more intended recipients (e.g., imported from the first user's contacts list) using their mobile device 96 via the system mobile application 147, may confirm the selected one or more intended recipients via the system mobile application 147, and may present the mobile device 96 proximate the properly configured/networked terminal; wherein electronic address information pertaining to the selected and/or confirmed intended recipients may be electronically communicated to the terminal, via wireless protocol, for processing a gifting transaction described herein. Even more alternatively, while not shown, a camera provided to the P-O-S checkout terminal or nearby kiosk 3 (e.g., a kiosk operably connected to the P-O-S checkout terminal) may capture contact information which may be displayed from the screen of the first user's mobile device 96, and, using image recognition software (e.g., OCR technology) provided to the P-O-S checkout terminal or nearby kiosk 3, may extract relevant recipient electronic information, may process the recipient electronic information, and/or may parse the information, as necessary to import the recipient electronic address information, without limitation. In this regard, a first user may engage their mobile device 96, open up a contact from a list of contacts stored on their mobile device 96, and display it in front of the camera for capture.

These and other convenient methods of providing user data 8 (e.g., recipient information) to the P-O-S checkout terminal as a system input 4 are anticipated. For example, in some non-limiting embodiments, recipient user data 8 may be contained/stored within a system card 19 in a usable digital format. Upon use of the card 19 with the P-O-S checkout terminal (e.g., tapping, scanning, swiping, or the like), a gifting prompt may be provided and displayed on one or more user interfaces 106 of the P-O-S checkout terminal via system software 147. If the first user wishes to perform a gifting option, the employee and/or the first user may select the gifting prompt. The gifting prompt may comprise a gifting icon, key, or the like (e.g., a “send1” button) provided to the one or more user interfaces 106. Upon engagement with the gifting prompt by the employee and/or the first user, a list of recipient user data 8 (e.g., such as system “friends” or third-party 93 “friends”) may be displayed on the one or more user interfaces 106. The first user and/or the employee may select one or more of the displayed recipient user data 8 from the list of recipient user data 8. For example, the employee may select one or more of the displayed recipient user data 8 based on verbal commands or instructions from the first user. A confirmation prompt may be provided and displayed on the one or more user interfaces 106 of the P-O-S checkout terminal (for example, adjacent the list of recipient user data 8), and upon engagement with the confirmation prompt by either of the first user and/or employee, the relevant recipient electronic address information may be extracted, imported, processed, parsed, or the like, as necessary to complete an electronic gifting transaction, without limitation. The system software 147 may calculate a total cost of the delivered funds, credits, or redemption information 64 purchased for others, and add it to the transaction total as shown above, wherein one or more receipts 20 may list the gifting transactions in an itemized manner. Cards 19 used with the system may be payment cards affiliated with financial institutions such as credit card companies, bank companies, and the like, without limitation. Cards 19 used with the system may be affiliated with vendors, chains, or franchises, without limitation. Cards 19 used with the system may be system cards affiliated with the system, without limitation.

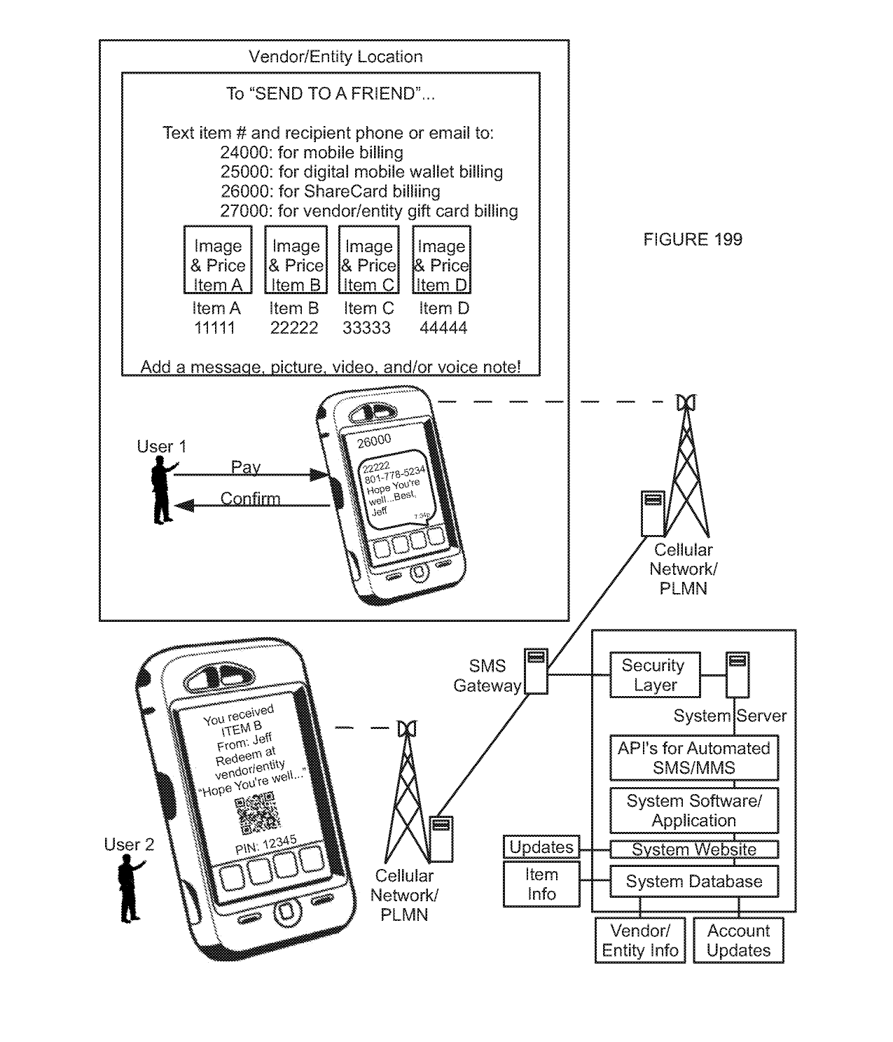

Turning now to FIG. 199, other embodiments may allow a first user to pay for items to be gifted to one or more second users (e.g., recipients) without necessarily involving payment to a P-O-S checkout terminal as done with the embodiments shown in FIGS. 195-198. As described in U.S. Provisional Patent Application No. 61/948,004 and U.S. Provisional Patent Application No. 61/943,376 (both of which are hereby incorporated by reference in their entirety), a first user may, in some non-limiting embodiments, access a system website 128 to load system credit to their phone number using traditional payment means (credit card number, bank account, gift card credit, check, etc.) prior to visiting a entity location. Alternatively, or in addition, the first user may purchase a system-compatible card 19 (e.g., “ShareCard” gift card) off a display rack at a retailer and add credit at the checkout point of sale where the card 19 is purchased. During or after activation, the added credit may be associated with a mobile device 96 number of the first user. The card 19 may be supported or otherwise recognized by a leading well-established bank or credit card company (e.g., VISA, Chase, US Bank, Bank of America, Discover Financial, American Express, MasterCard, etc.). In some embodiments, the system-compatible card 19 may be unique to a particular entity, franchise of affiliated vendor/entities, or a substantially universally-accepted gift card.

In some embodiments, once the funds are associated with a mobile device 96 of the first user (e.g., such as associated with the electronic address or “number” of the first user's mobile device 96), the first user may utilize his/her mobile device 96 to perform one or more gifting functions. As shown in FIG. 198, a participating entity 65 may, in some instances, provide a unique item number to each item, product, good, or service sold by the participating entity 65. It should be understood that the unique item number may be any code which may include non-number characters. The item number may be arbitrary, a system-provided number, a participating entity-provided number, a UPC number or portion thereof, a stock number, an inventory number, or a SKU number or portion thereof, without limitation. The first user may utilize SMS or MMS-based text messaging protocols to send an item to a friend (although other messaging protocols discussed herein like email and/or social media may be equally employed, without limitation). For example, the first user may text the selected item number to be gifted and recipient info (e.g., in the order instructed), in a text message, to a system electronic address (e.g., which may be displayed), in order for system components to withdraw credits available to the first user and purchase and electronically deliver the item to a recipient, via the provided electronic address. In the particular non-limiting embodiment shown, the first user wishes to send “Item B” to a second recipient user for a certain price and follows the provided instructions. The first user texts the item number for Item B to 26000 (the provided system electronic address) to purchase and send electronic redemption information 64 pertaining to the Item B to the second user, utilizing pre-loaded credits which have been associated with the first user's mobile device 96. As suggested by the figures, one or more system electronic addresses may be provided, for example, to perform different functions regarding an item, product, good, or service. Moreover, it should be appreciated that one or more mobile billing principles may be employed, without limitation, wherein an electronic communication made by the first user requesting a gifting function to be performed for an intended recipient, the first user's mobile device bill (e.g., phone bill, data plan bill, service plan bill, monthly statement) may be adjusted to reflect an invoice statement comprising a charge in the amount of Item B, or in an amount slightly greater than Item B (e.g., an additional service/transaction fee).

According to some embodiments, the first user may text one or more item numbers for the desired item(s) to an electronic address using their mobile device 96 to purchase and send the desired item(s) to one or more second users. Robust parsing software 147 may be implemented by the system and provided to system components to allow the first user to provide more than one item numbers and/or more than one electronic address (which may be similar or different types of electronic addresses) in a single electronic communication to the system-provided electronic address. This may be done utilizing pre-loaded credits which have been associated with the first user's mobile device 96. The sent message received by a recipient may comprise redemption information 64 such as an electronic pre-paid voucher which might contain a format, content, verbiage, codes, image data, audio data, security/authentication data, passwords, pass codes, PIN numbers, instructions, etc., as necessary to allow the recipient to use/redeem the redemption information 64 with a participating entity 65. The redemption information 64 may be pre-vetted by one or more participating entities 65 and system to ensure compliance and/or compatibility with the system and components thereof. According to some embodiments, a number of “canned” messages containing such information may be provided to the system database 129 (e.g., via the system website 127 through a private portal); for example, wherein a participating entity 65 can upload a file containing preferred redemption information 64. In some preferred embodiments, each item, product, good, or service associated with the system may have its own pre-“canned” message affiliated with its respective item number (this may be appreciated from the figures). In this regard, when the system receives an item number in combination with a send or buy or regift request communication, its automated software 147 may be able to readily access the database 129 to find the respective item number, and may determine which message to send to a recipient, and may how much to debit the account associated with the electronic address of the incoming send or buy or regift request communication (if applicable). Such executions may involve other components which are known in the art for banking, text televoting, and other known SMS-based or push/pull messaging marketing solutions. For example, participating entities 65 such as manufacturers of items, products, or goods, may sign into their respective system accounts by accessing a system website 137, logging into their system profile 130, and uploading redemption information 64 such as codes, price information, UPC barcode information, and the like (via manually entering the data into respective web submission fields, or via system-formatted XML file uploads, or the like). Alternatively, a system API may be used with software of a participating entity 65 to enable the participating entity 65 to modify system database 129 contents. The system may use the provided redemption information 64 to generate coupons to be electronically-delivered to recipients upon request communications made to system components. In some embodiments, data files containing pre-vetted spreadsheet formats may be periodically provided to the system which can be incorporated into one or more system databases 129, or which can be used to update information contained within the database 129. According to some non-limiting embodiments, the system may (via the system's financial institution 163) pre-pay a participating entity 65 (e.g., a manufacturer/service provider) for redemption information 64 pertaining to a number of pre-paid items/products/goods/services to be delivered, for example, in advance. Or, according to some embodiments, the system may pay a participating entity 65 upon a claim from the participating entity 65 being submitted to the system (e.g., wherein a redeeming participating entity may file a claim for reimbursement to the system directly or to the system indirectly through a claim submitted to the manufacturer/service provider of the items, products, goods, or services exchanged for redemption information 64). In some embodiments, the system may directly compensate a redeeming participating entity 65 (immediately, or as a postponed disbursement of funds or credits), and then the system may file a claim for reimbursement from the manufacturer/service provider of the items, products, goods, or services exchanged for redemption information 64. Such aforementioned business methods are non-limiting and mentioned for example purposes only. It is envisaged that many different business models may be employed, depending on a plethora of factors including, but not limited to: the nature of the items/products/goods/services, the nature of the redemption information 64, the manner in which the redemption information is processed and/or utilized, the terms and conditions outlined in system user agreements, and/or the nature in which participating entities control distribution, allocation, and financials, without limitation.

Alternative instructions may be provided for different methods of billing. For example, mobile billing (wherein the cost of an item (e.g., item B) may be added to the first user's mobile service provider monthly bill) may alternatively be used to pay for and send one or more items (e.g., item B) to one or more second individuals who may or may not be system users. Alternatively, the first user may purchase one or more items (e.g., item B) for one or more second individuals with financial credentials associated with the first user's digital mobile wallet. Alternatively, the first user may pay for one or more items (e.g., item B) using the first user's in-store gift card credit which has been associated with the first user's mobile device number. This will be readily appreciated and understood from FIG. 199, particularly by those having an ordinary skill in the mobile payment arts.

The system may, in some embodiments, be integrated with one or more SMS/MMS auto-responders/autodialers for sending push, pull, SMS alerts, one-time passwords (OTP), and the like in an automated fashion. According to some embodiments, the system may be integrated with an audio-based human-machine interface (HMI). It is anticipated that more complex systems may be employed to provide both robust control environments and flexible and/or scalable operating environments which are able to connect seamlessly to multiple SMSC operators in the country or countries of operation. Systems described herein may, depending on volume of messages sent, received, pushed, and pulled, comprise simple modems or may connect over one or more leased lines using low level communication protocols (e.g., SMPP, UCP, etc.), without limitation. Systems described herein may cater to providing failover mechanisms and least-cost routing options. Software utilized may be proprietary, open source banking platforms, or the like to support similar functions to that of existing mobile banking and SMS payment systems, as well as mobile marketing systems (e.g., mobile SMS marketing systems, methods, software, hardware, servers, gateways, controllers, and other equipment and networked system components). Systems, apparatus, and/or methods described herein may comprise means for identifying electronic addresses of incoming electronic communications, such as from incoming electronic messages. For example, mobile phone number and/or SMS email addresses (e.g., Verizon Wireless® @vtext.com addresses, Cingular® @mobile.mycingular.com addresses, T-Mobile@ @tmomail.net addresses, and Boost Mobile @myboostmobile.com addresses, etc.) may be identified using one or more system components, without limitation, for example, using header information or POST data, without limitation. Systems, apparatus, and/or methods described herein may comprise means for identifying mobile device electronic addresses, numbers, etc., and/or software means for removing non-alphanumeric characters and/or spaces (e.g., parsing algorithms). The system may, in some embodiments, comprise one or more of the following: SMS gateways (ETSI, GSM), SMSCs, terminals (e.g., DECT), direct-to-mobile gateway (e.g., GSM gateway) appliances having wireless GSM connectivity, means for allowing SMS/MMS text messages to be sent and/or received by email, from web pages, and/or from other software applications (e.g., system applications 147 and/or social media 93 applications) by acquiring a unique identifier from a mobile device's SIM card, SMS aggregators for providing SMS services to customers, means for regulating number of SMS messages per SIM, ODBC to connect to a system database, HTTP interfaces to interact with third-party applications, one or more direct-to-SMS gateways, means for connecting directly to a mobile operator's SMSC via the internet or direct leased line, short message peer-to-peer (SMPP) protocol, third-party applications (e.g., Microsoft Outlook, AOL Instant Messenger, ICQ, SMS send platform, Windows Live Messenger, Windows SMS Sender, Skype, Yahoo! Messenger, etc.), one or more email clients/programs (e.g., Eudora, Thunderbird, etc.), ASCII “text-only” mode software, HTML-based text software, SMS gateway domains, SMS center numbers, SIM numbers, character count/message size limiting or logistics software, voice-over-IP communication systems, eAPI's (e.g., BulkSMS), ANSI CDMA networks, Digital AMPS, satellite networks, land-line networks, short message mobile terminated (SMS-MT) point-to-point protocols, short message mobile originated (SMS-MO) point-to-point protocols, short message point-to-point (SMS-PP) protocols, optional cell broadcast messenger protocols (SMS-CB) for local users, SMSC foreign number blocking means, GSM/3GPP/3G/etc. network communication means, SMS alternative protocols (e.g., J-Phone's SkyMail, NTT Docomo's ShortMail, etc.), STMP over TCP/IP standard mail protocols, “store and forward” mechanisms provided to a SMSC, “forward and forget” mechanisms provided to a SMSC (e.g., for SMS-MO and SMS-MT), satellite communication protocols, user data headers (UDH) and UDH interpreters, data/metadata routers, long SMS components, concentrated SMS components, SMS gateway providers, SMS SS7 connectivity providers, aggregators, local or international termination models, message service centers, public land mobile network (PLMN) communication means, direct-to-mobile gateway appliances, caller ID software, HTTP to SMS API's, TMS protocols, Flash SMS delivery means, dialing and/or messaging short code (i.e., “special shorter phone numbers”) implementations, SMS traffic switching services, mobile web, mobile client applications, mobile channel platforms, SMS with mobile web and secure SMS, push to talk services and/or messaging protocols, mobile dial codes, operator messaging, extended messaging services, CSCA short code registry access means, open mobile alliance (OMA) standards, email-to-SMS services, SMS-to-email services, and/or SMS home-routing services, without limitation.

In some embodiments, texts may be sent to a system email address, wherein the user's mobile device number is easily identifiable in the “from” field. For instance, in the heading an incoming SMS or MMS message coming into the system may be in the form of “8017381928@txt.att.net”. The requesting user's mobile device number may be extracted from the prefix of this “from” heading, or the system may reply to the incoming address as is. It will be understood that multiple “back-end” components of the system may utilize various components of a mobile network to verify a user's mobile device number. For example, ICCID, International Mobile Subscriber Identity (IMSI), Mobile Subscriber Identification Number (MSIN), individual account identification number, issuer identification number, Authentication Key (e.g., Ki, Kc, RAND, SRES), Local Area Identity (LAI), SMSC (Short Message Service Center) number, Service Provider Name (SPN), Service Dialing Numbers (SDN), Advice-Of-Charge parameters, and Value Added Service (VAS) applications and/or the like may be utilized or otherwise form subcomponents of the greater “system”; for example, during transactions, operations, functions, and executions which may be necessary to enact the inventive methods and concepts described.

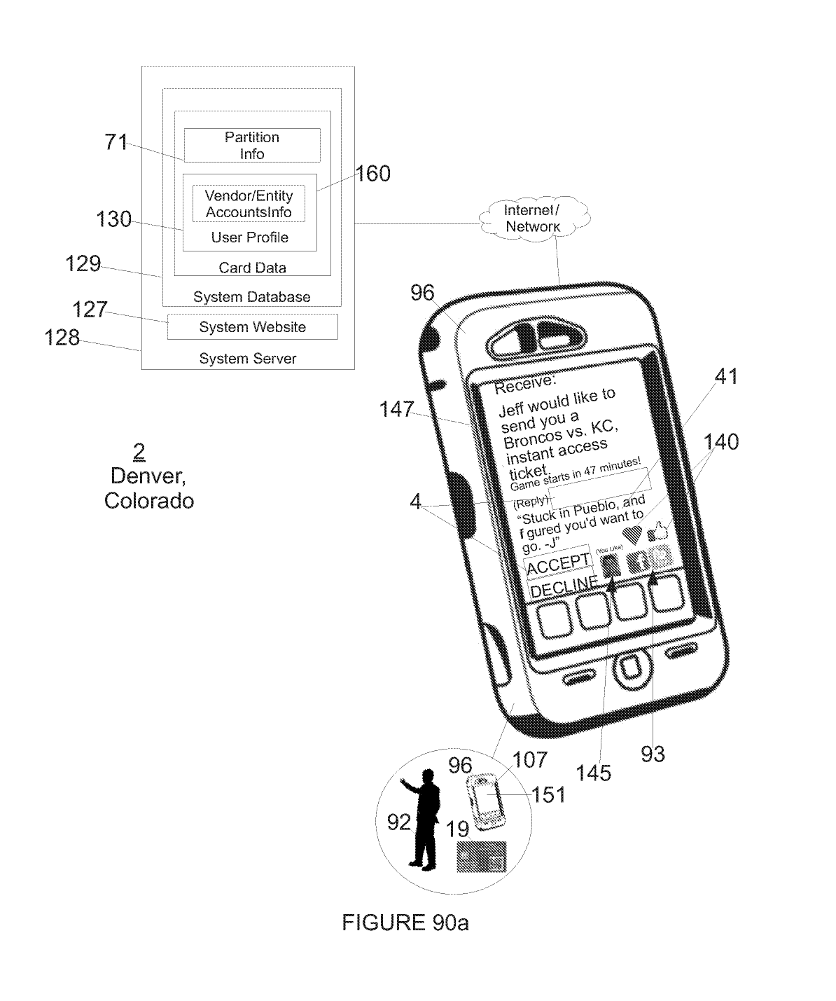

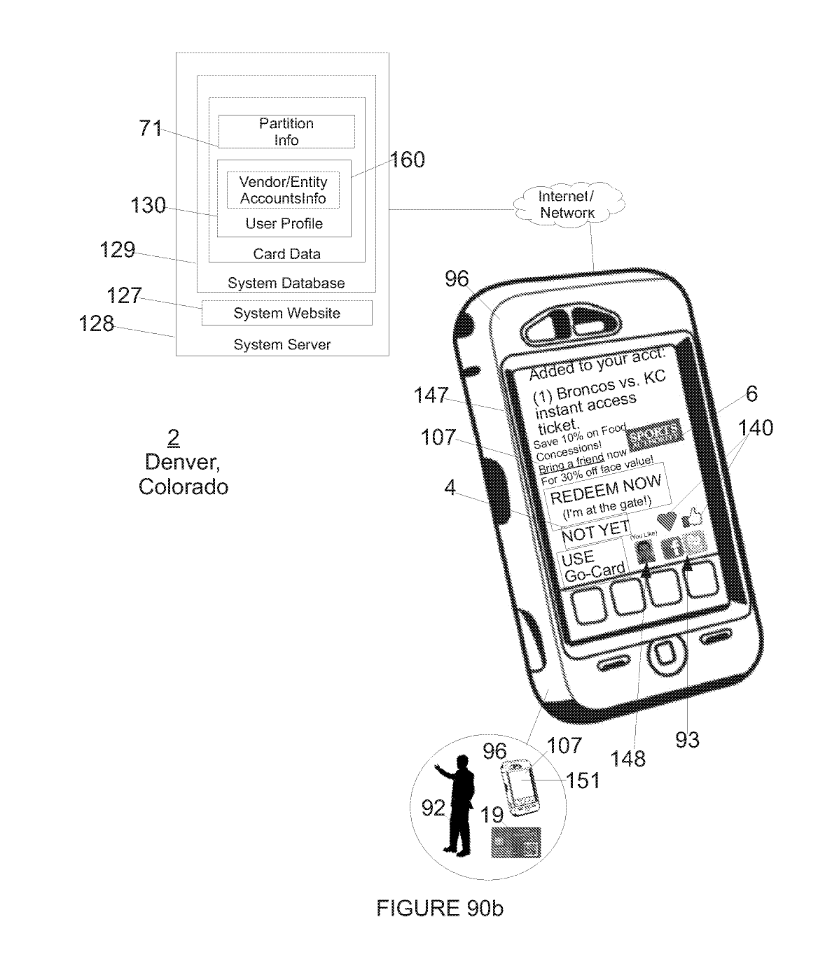

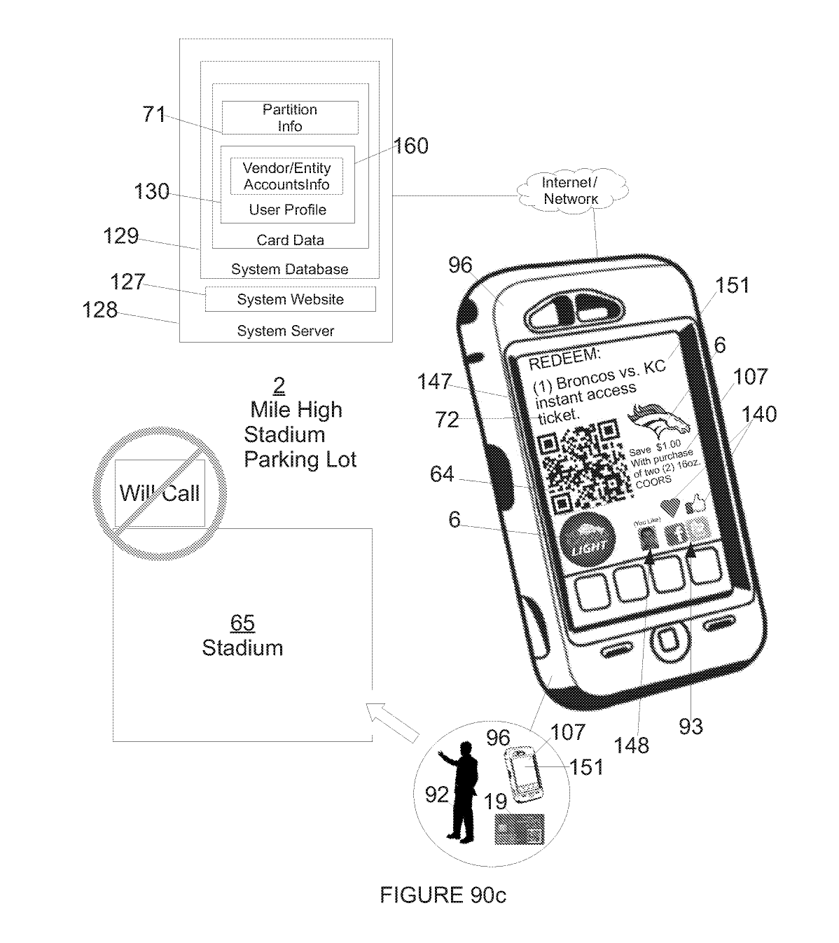

Data Encryption Standard (DES), Advanced Encryption Standard (AES), and/or Triple DES standards may be incorporated. Support for the mobile-to-mobile text messaging services described herein may incorporate or otherwise include components from any existing mobile technologies, such as ANSI CDMA networks and Digital AMPS, as well as satellite and landline networks. Send (mobile terminated) and receive (mobile originated) rich content through MMS A2P (application-to-person) mobile networks is also envisaged. Proximity marketing GSM 03.41 protocols may be employed in certain embodiments to improve user experiences. In some instances, users may (while in a location near a particular display, broadcast, radio station, TV station, billboard, or sign) be able to make certain first transactions using the system, wherein (while in another location near another display, broadcast, radio station, TV station, billboard, or sign), users may be able to make certain second transactions; wherein the first transactions may be different from the second transactions. In this regard, both time-based, and location-based protocols may be implemented with the system, and certain restrictions may be made based on such protocols (see FIGS. 90b and 183). Messages described herein may be sent P2P (person-to-person) as necessary to facilitate functions. Messages described herein may be sent via SMS from an internet connected PC (Internet to Person—I2P), or sent or received using any software application (Application to Person—A2P) as is necessary to facilitate the functions, actions, and executions described herein.

In some embodiments, messages sent by users to system components may be routed to or through a short message service center (SMSC), which may provide a “store and forward” mechanism. In this regard, the system may attempt to send messages to the SMSC's recipients. If a recipient is not reachable, the SMSC may queue the message for later retry. Mobile terminated (MT, for messages sent to a mobile handset) and mobile originating (MO, for those sent from the mobile handset) operations may be supported in various embodiments.

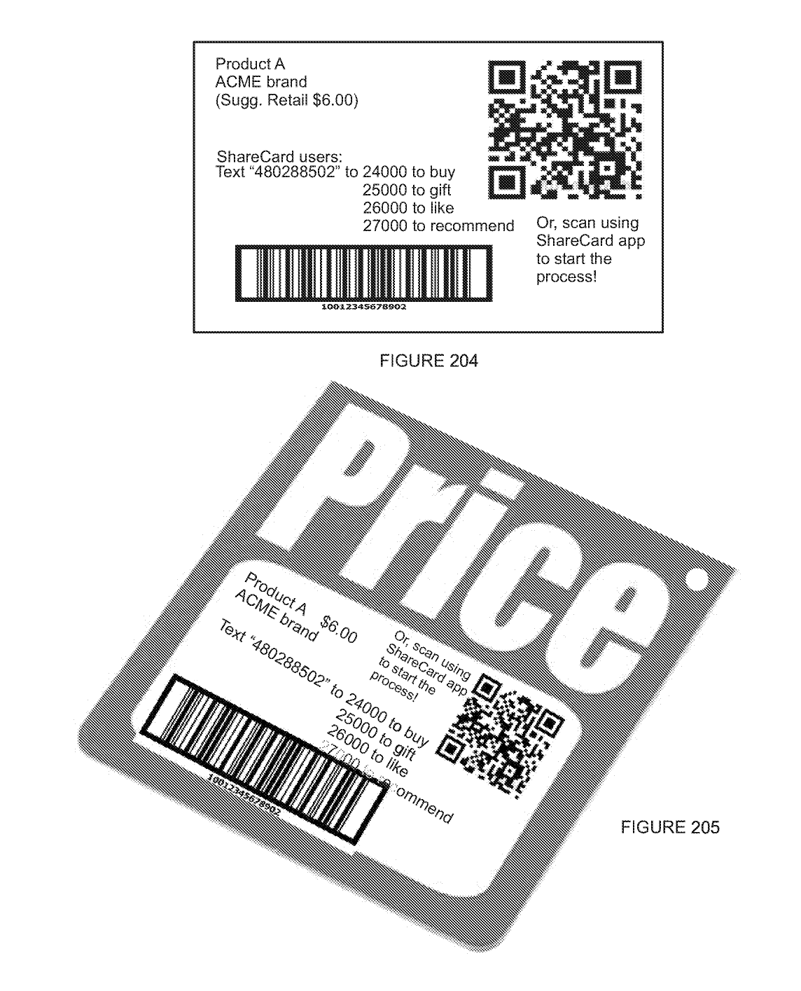

As shown in FIGS. 204 and 205, instructions may comprise machine-readable indicia, such as a 1D or 2D barcode, data matrix code, or QR code. The first user may utilize a system application 147 to scan the respective machine-readable indicia to capture item data, cost information, etc. The system application may utilize the first user's location data to calculate sales tax of a scanned item. The first user may gift one or more scanned items by entering recipient information into data input fields using a mobile application 147, and/or by selecting one or more recipients from contacts stored on the first user's mobile device in a contacts list. In the latter case, digital contact card information may be utilized to deliver, electronically, redemption information 64 which may comprise one or more eGift certificate(s), voucher(s), coupon(s), store credit(s) or other vendor/selling entity-recognized funds or credits, to one or more recipients. For example, vCard information may be attached to an SMS/MMS/mobile message, or email addressed to a system electronic address. Items, products, goods, or services may be provided, for instance, with integral labeling, printed matter, stickers, labels, or tags such as the ones shown in the figures. In this regard, users may more conveniently and personally pay for and electronically gift specific items when shopping or on the go.

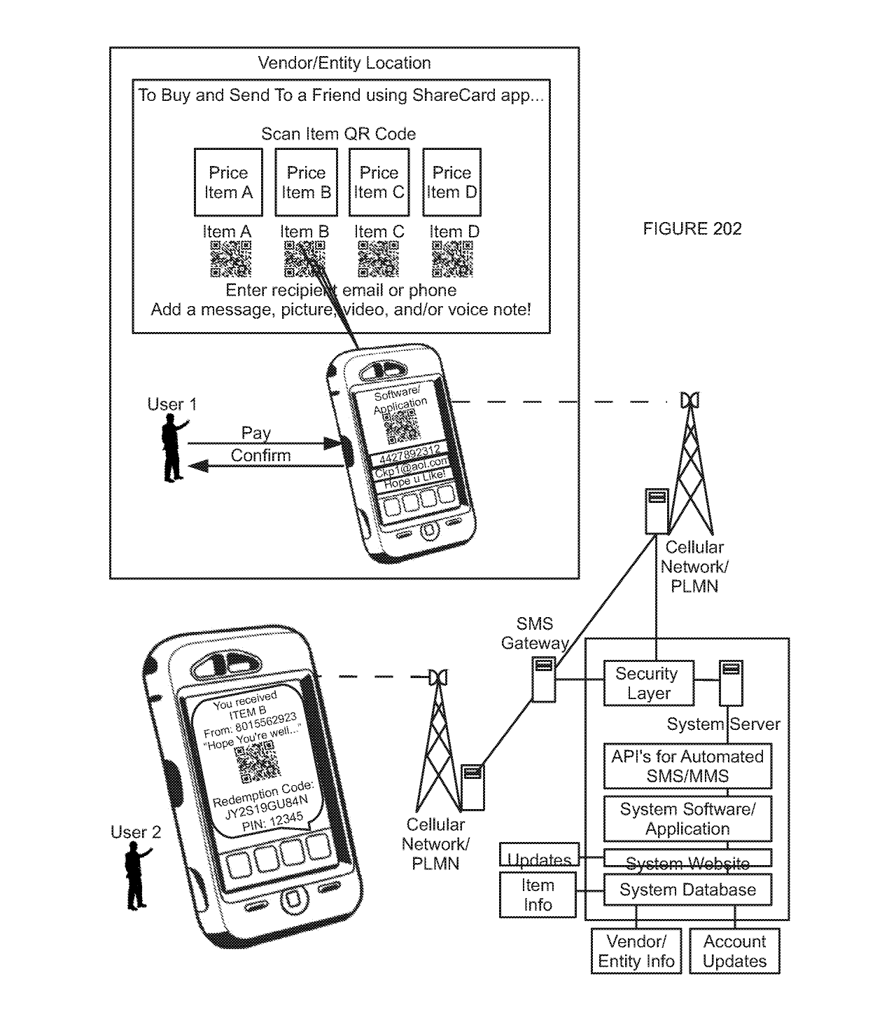

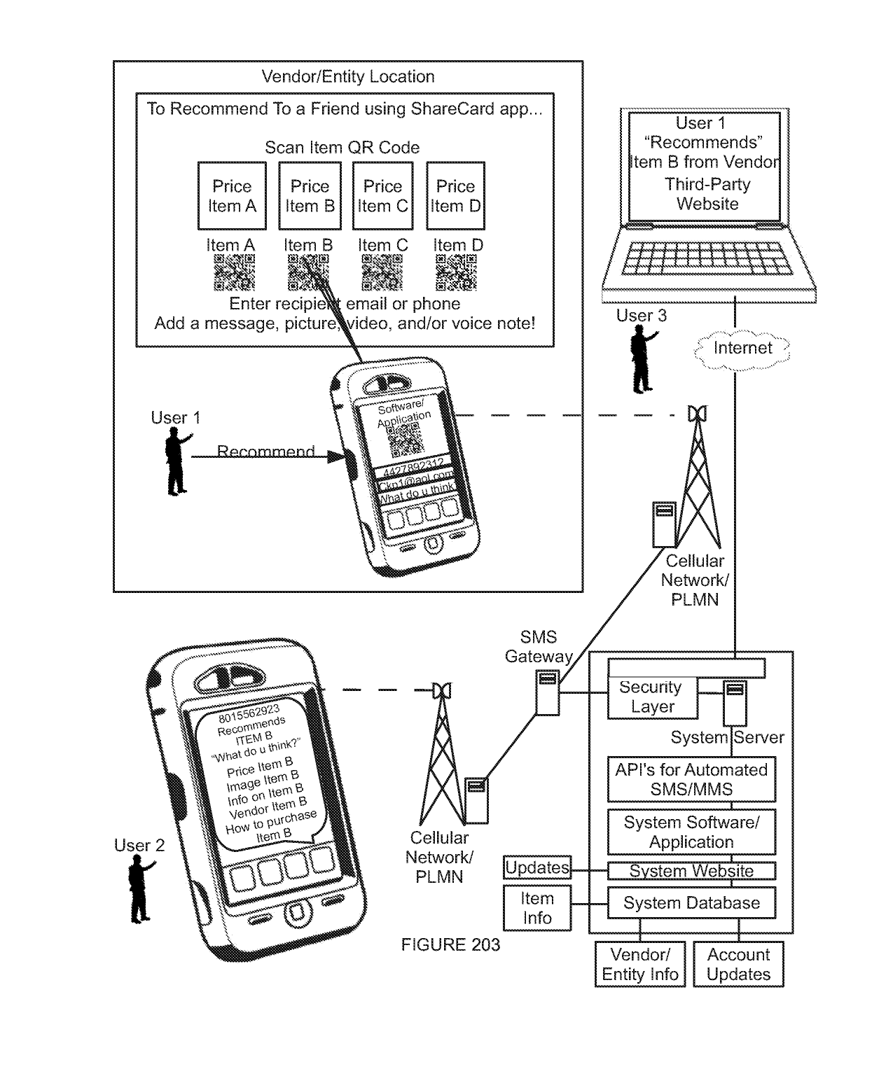

Similar methods may be applied for social media functions. For example, recommendations, and favorable opinions such as “LIKE”s or “+1”s or “thumbs up” may be performed with physical items, products, goods, or services using components of the systems and methods provided herein. Additionally, social media posts, such as Facebook wall posts, Twitter “Tweets”, etc. may be made easier. Turning now to FIGS. 201, 202, and others, a social media application or system application integrated with a social media site 93 may be installed on a first user's mobile device 96. The application 147 may be equipped with or operatively coupled with QR code scanner/reader software or means for scanning/reading other machine readable indicia (i.e., “barcode”) scanner). When shopping, the first user may scan a label or tag of an item, product, good, or service, or may scan its packaging, or in cases when a tag or label is not present, may scan a nearby display (e.g., poster, card, rack) comprising similar indicia. The application may then present the first user with the option to provide a favorable opinion about the item, post about the item, “follow” the item, recommend the item, obtain an online review of the item, send the item to a friend, buy the item, add the item to a wish list, etc. If the first user wishes to recommend the item for one or more specific second users, the first user may select the respective friends, followers, connections, contacts, or relatives to which the first user wishes to recommend the item. In order to personalize the posts or recommendations, the first user may add a personal greeting, audio recording, picture, or video.

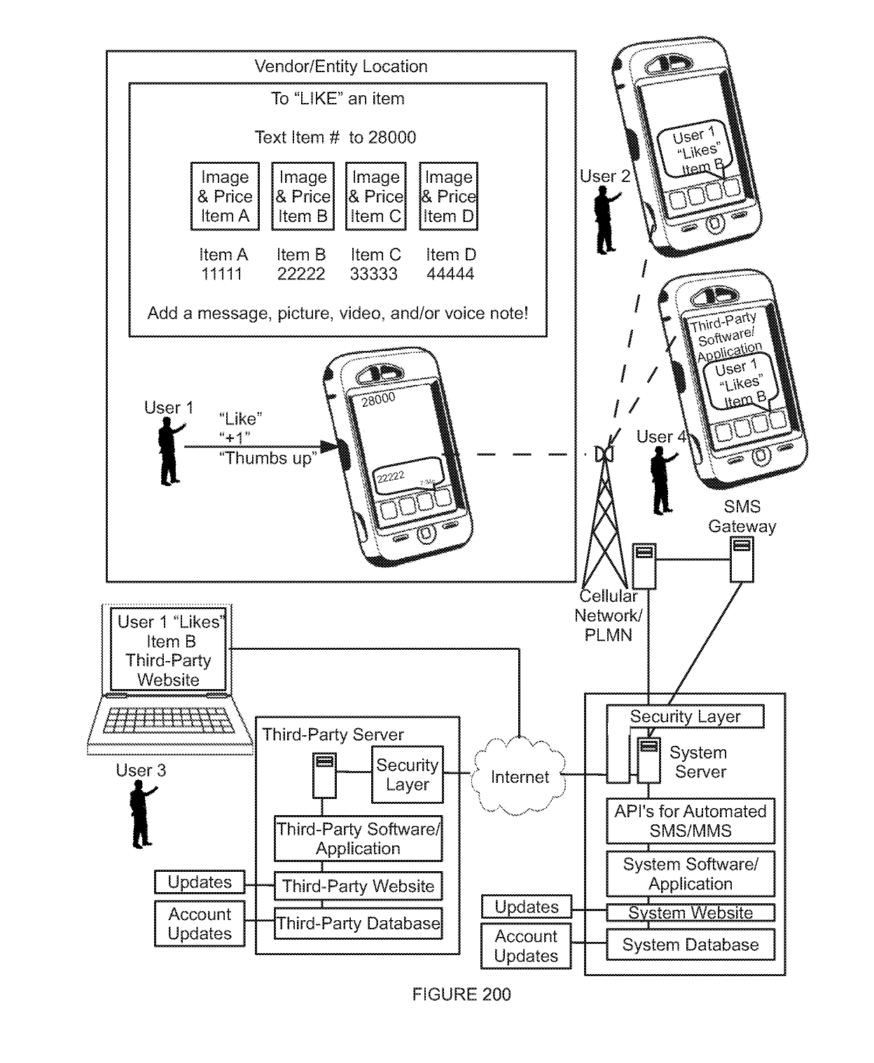

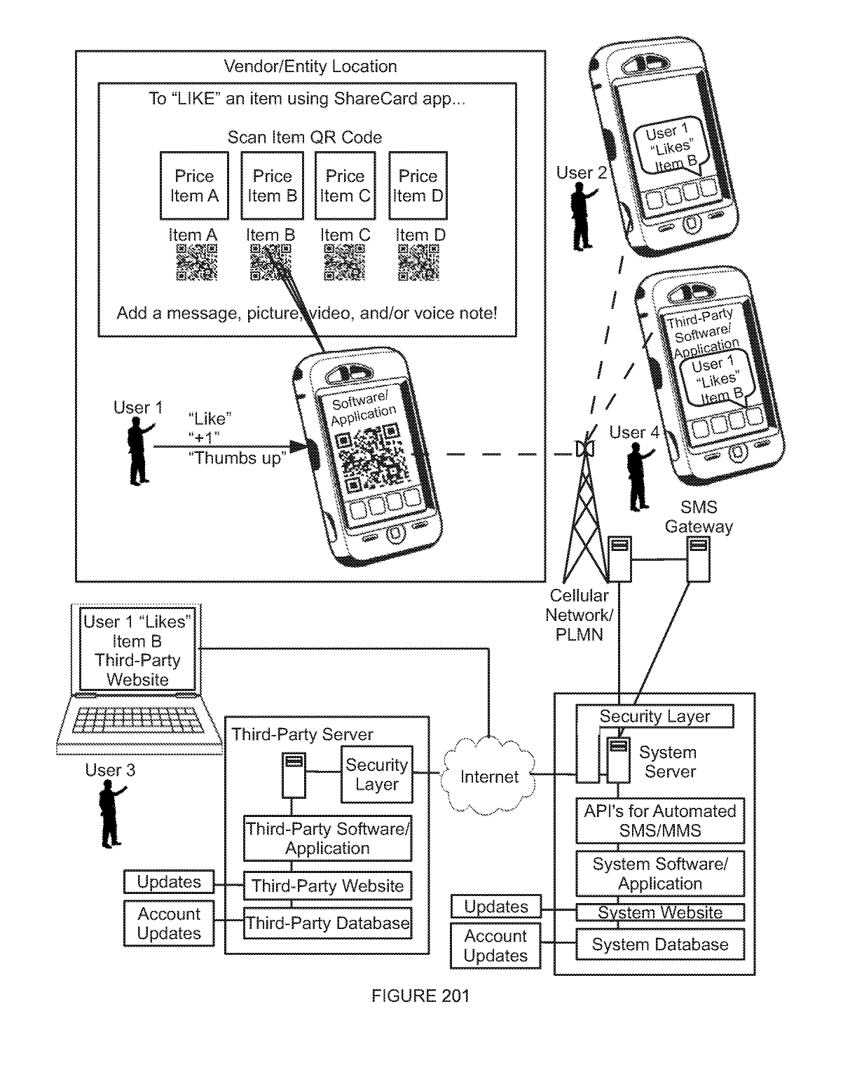

In its most simplistic form, a user may associate their mobile device number with their online social media profile(s). For example, in the first user's preferences page of a social media website 93 or mobile application version thereof (e.g., Facebook or Twitter), a user may enter their phone number. Or the user may login at the system's website to verify profile credentials and associate their phone number. In some embodiments, a user may login to the system website using their social media website 93 credentials. In some embodiments, a user may log into the system website, may provide their social media website account or profile number, the system may provide instructions to their email address or via private messaging to the user's social media inbox, and the user may follow the instructions to complete the linking function. Instructions may be provided throughout brick and mortar facilities, billboards, signs, displays, labeling, and throughout the physical world in general, including venues/locations 2 of participating entities 65. The instructions may comprise an instruction to text an item number to a unique short-code which may be affiliated with the respective social media institution. In doing so, the social media institution may receive the instructions delivered via SMS along with the user's caller identification number (e.g., mobile phone or device number) and the relevant item number. The social media institution (or a third party) may facilitate a wall post, feed, or other communication for the user, based on the input received by the user (i.e., based on the SMS instruction). For example, as shown in FIG. 200, a first user may share with social media contacts, connections, followers, and/or friends, that he/she likes an item (e.g., likes “item B”) by texting the item number (e.g., 22222) to a short-code (e.g., “28000”) which may be affiliated with a social media institution (e.g., Facebook) and/or may be a system electronic address. In this regard, users which do not have smart phones or intelligent mobile computing devices, or which do not have expensive data plans, may connect and share and/or utilize gifting features (e.g., on the go) without necessarily requiring a mobile application to participate.

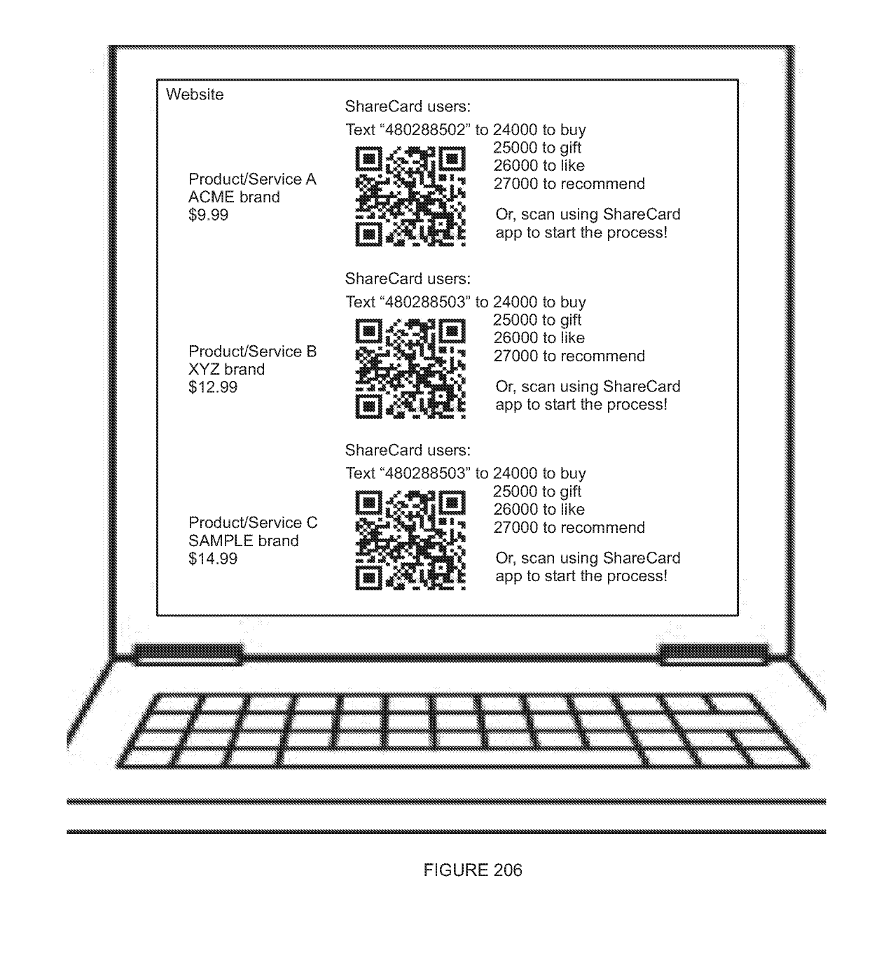

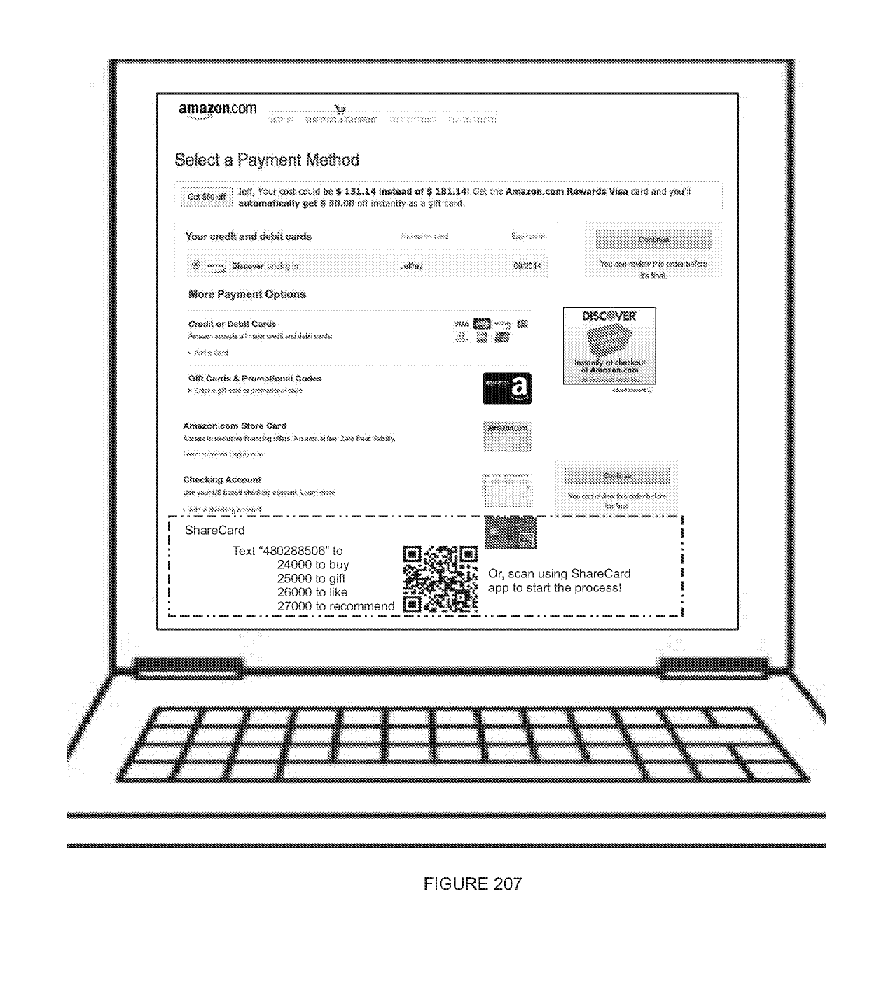

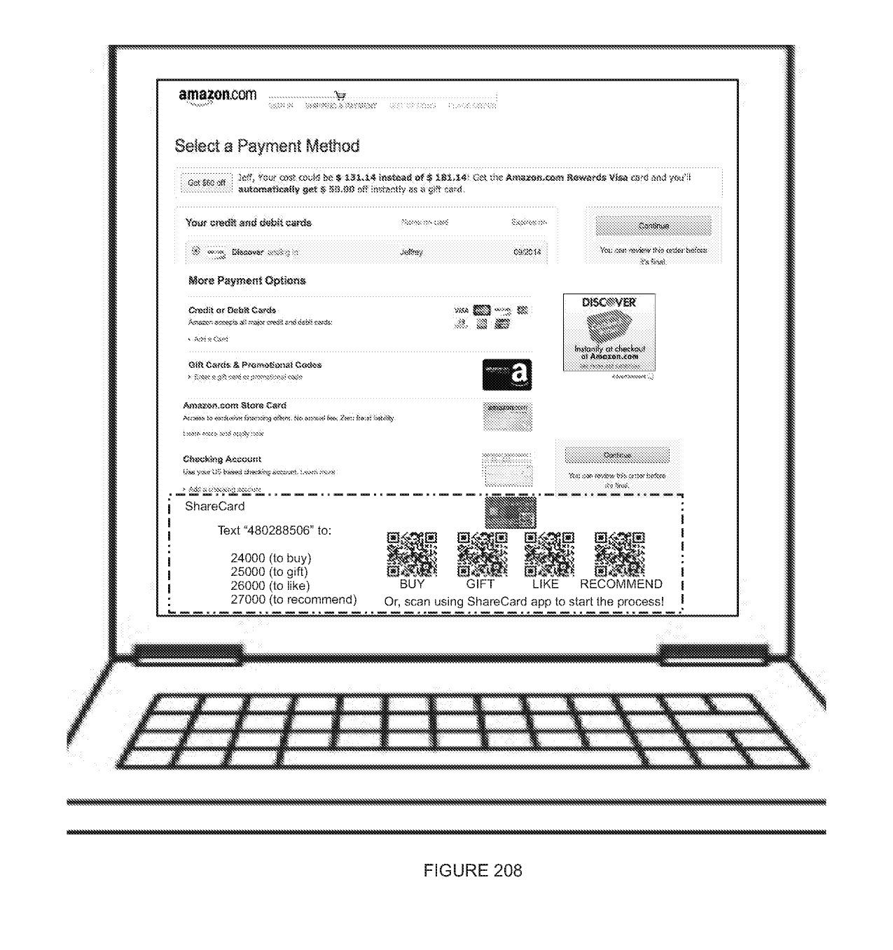

Turning now to FIG. 206, similar systems and methods may, in some embodiments, be employed in virtual/online marketplaces, in combination with, or alternatively to the physical or brick-and-mortar methods described above. For example, a website may display a number of purchasable items, products, goods, or services. Adjacent to the number of purchasable items, products, goods, or services or on the item's checkout page, a QR code or other machine-readable indicia may be displayed. To accommodate users without smart mobile devices, additional instructions may be provided as shown. A user may scan the machine readable indicia with a mobile application to purchase, gift, like, or recommend an item. In this regard, a user need not re-enter personal information or create a username and login ID on a website each time the user wishes to make a purchase. For example, as shown in FIGS. 207 and 208, which exhibit a typical checkout page, a user may utilize their mobile device (digital wallet, or credit associated with their mobile device number) to checkout.

If using a system mobile application, a user may, in some non-limiting embodiments, only need to create one account profile 130 and enter a shipping address, name, and/or user information once, upon download or just after download of the system mobile application 147. A user may, in some non-limiting embodiments, create an account profile 130 via the system website 127 and may enter their shipping address, name, and/or user information, via one or more input fields, to populate database 129 information pertaining to the created account profile 130. In some non-limiting embodiments, a user may text message shipping information, name information, and/or user information to a system electronic address (e.g., via mobile device 96, phone, or email client). For example, the user may provide “123Apple St. Alexandria, Va. 22314” in the body of a text message addressed to and sent to a system electronic address, or the user may provide the like in the subject line and/or body of an email message addressed to and sent to a system electronic address, or the user may text their entire “contact” (e.g., vCard) information by attaching it to or embedding it into the body of a text message sent to a system electronic address, or the user may text their entire “contact” (e.g., vCard) information by copying it and pasting it into the body of a text message sent to a system electronic address, or the user may email their entire “contact” (e.g., vCard) information by attaching it or embedding it into an email sent to a system address, or the user may email their entire “contact” (e.g., vCard) information by copying and pasting it into one or more portions of an email sent to a system address, or the like, without limitation. In addition, or alternatively, a user may call an automated, voice-command enabled, hotline and may type in their address or speak or say their address, which may then be compared, using system software 147, to a postal system database and which may be repeated/reiterated to the user for validation. If the repeated address is not correct, the user may repeat the process until it is correct by providing one or more inputs 4, such as a designated keypad entry (e.g., pressing number 7 for incorrect) or saying a respective command (e.g., “No, that's not correct”). If the repeated address sounds okay, the user may confirm it by providing one or more inputs 4, such as a designated keypad entry (e.g., pressing number 2 for correct) or saying a respective command (e.g., “Yes, that's correct”). Other methods of updating a user's profile 130 with information are anticipated.

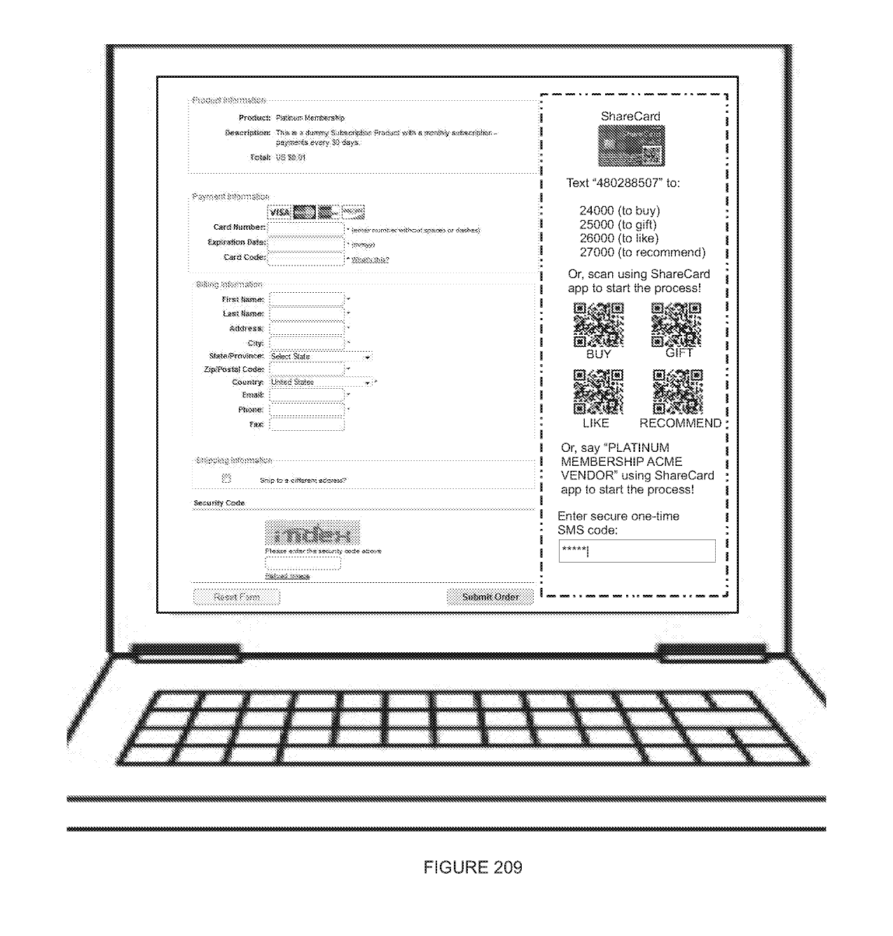

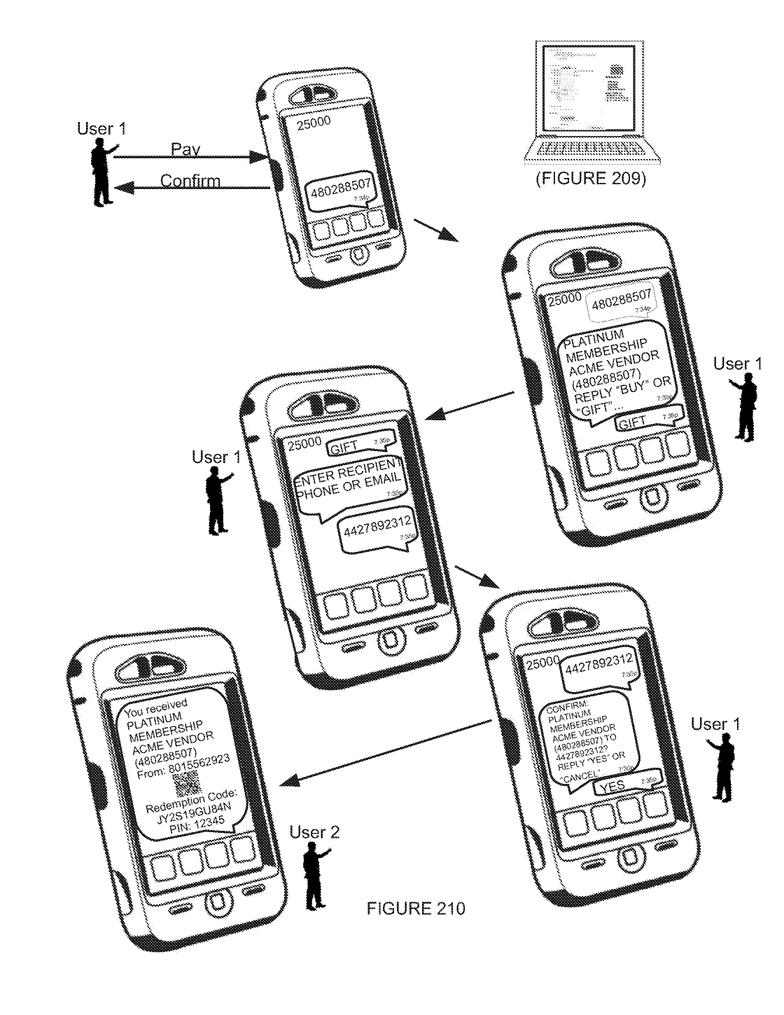

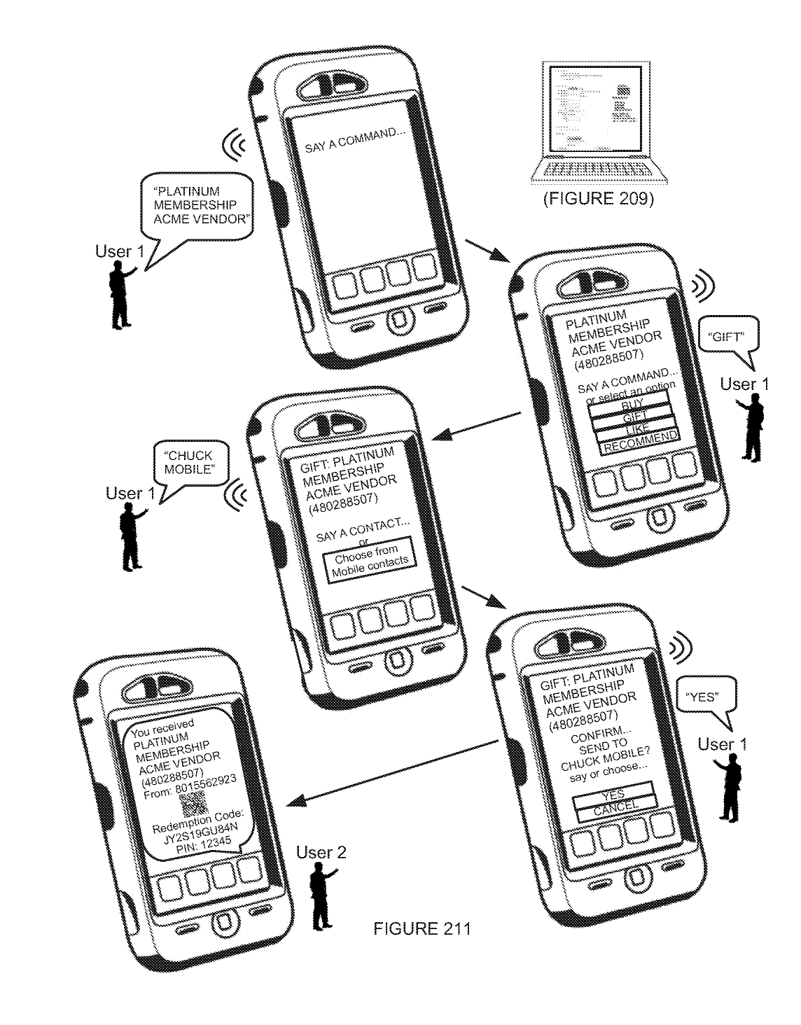

According to some embodiments, once the system database 129 has the user's mobile phone number and shipping information, the user may then shop online, visiting multiple non-affiliated sites, and may checkout using their mobile device 95 with very few steps (e.g., scan, then select “buy”, “gift”, “like”, or “recommend”, and then press submit), wherein system software 147 may communicate with respective system components such as the website host, the system server 128, and the system database 129 to complete the transaction. As shown in FIGS. 206 and 209, a temporary order reference number may be displayed on a website checkout page, which may, for example, be generated by system software 147; wherein a user may text the temporary order reference number to a displayed vendor electronic address or a system electronic address (e.g., a main system hotline) as instructed, without limitation. In some embodiments, voice command software (e.g., preinstalled voice-to-text software) may be employed on the user's own mobile device 96 to facilitate transactions (e.g., to help with importing information to SMS and/or email messages, without limitation). In some embodiments, a system application 147 installed on the user's own mobile device 96 may comprise voice command software to give the user voice command capability. In some simplistic forms, embodiments may comprise the step of a user calling a system electronic address (e.g., a toll-free hotline) to take advantage of the system's own advanced voice-command software, wherein the user may say or enter (using the phone keypad), one or more codes provided to the website; wherein one or more other inputs 4, such as card 19 information may also be spoken or entered (using the phone keypad), to complete the transaction, without limitation. In some embodiments, a user may install voice command software onto their mobile device 96 or computer 95 (e.g., a web browser plug-in/add-on, or a specialized web browser 96); or the user may install a system mobile app 147 which may be configured for voice command recognition software. As an optional measure of security, one or more one-time passwords/pass codes may be sent to the user's mobile device 96 (e.g., via SMS/MMS, mobile messaging, voicemail, email from the system), wherein the user may, via the website, be prompted to enter the one or more passwords/pass codes into one or more fields provided on the website's checkout page. Various other combinations and/or permutations of the above method steps are anticipated.

Alternatively, in some embodiments, if not using a system mobile application 147, a user may visit a system website 127, may sign up for and/or create a single system account profile 130, and may add all necessary user data (e.g., shipping info, personal data, banking data, etc.) to the single system account profile 130. The user may, in some embodiments, associate his/her mobile device 96 number (e.g., cell phone number) with the system account profile 130. Thereafter, the user may shop online and then checkout via SMS with their mobile device 96 for a plurality of participating entities 65 which may or may not be affiliated with each other as demonstrated in the figures, without limitation.

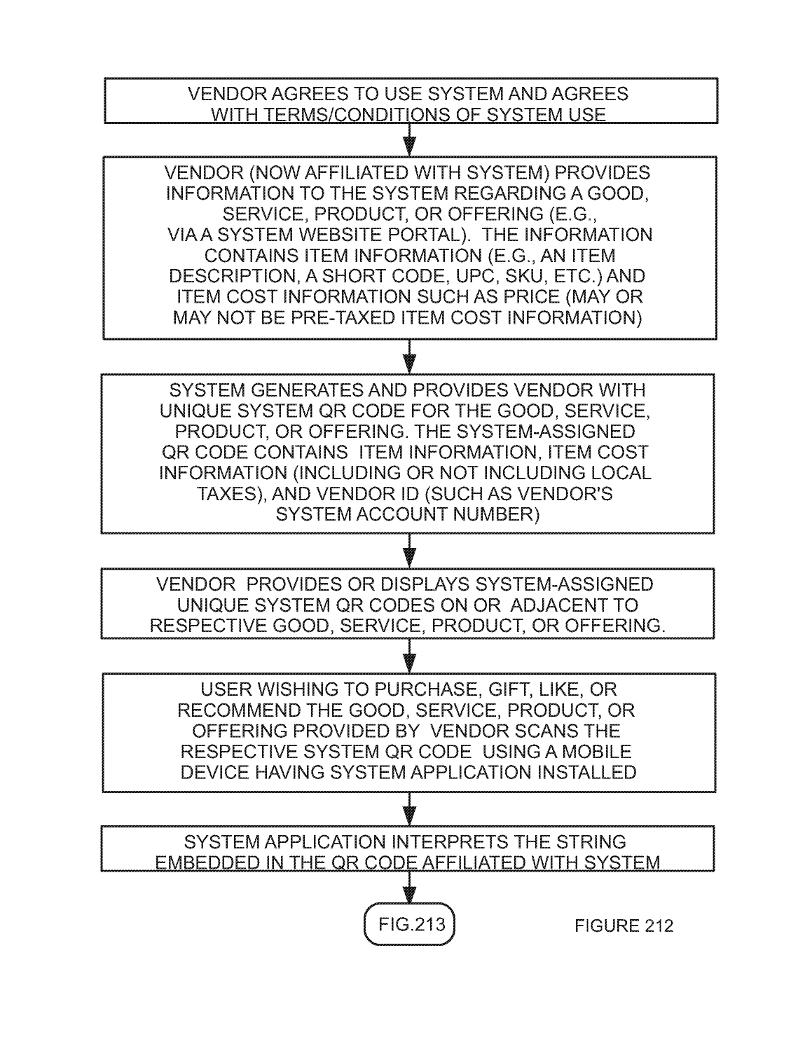

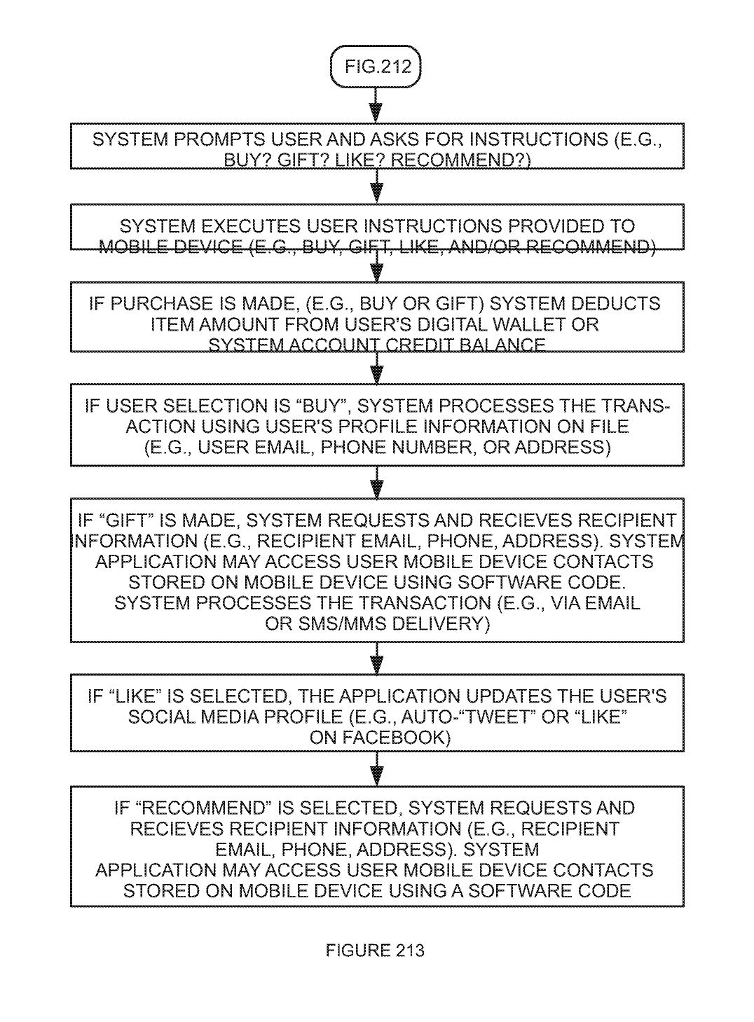

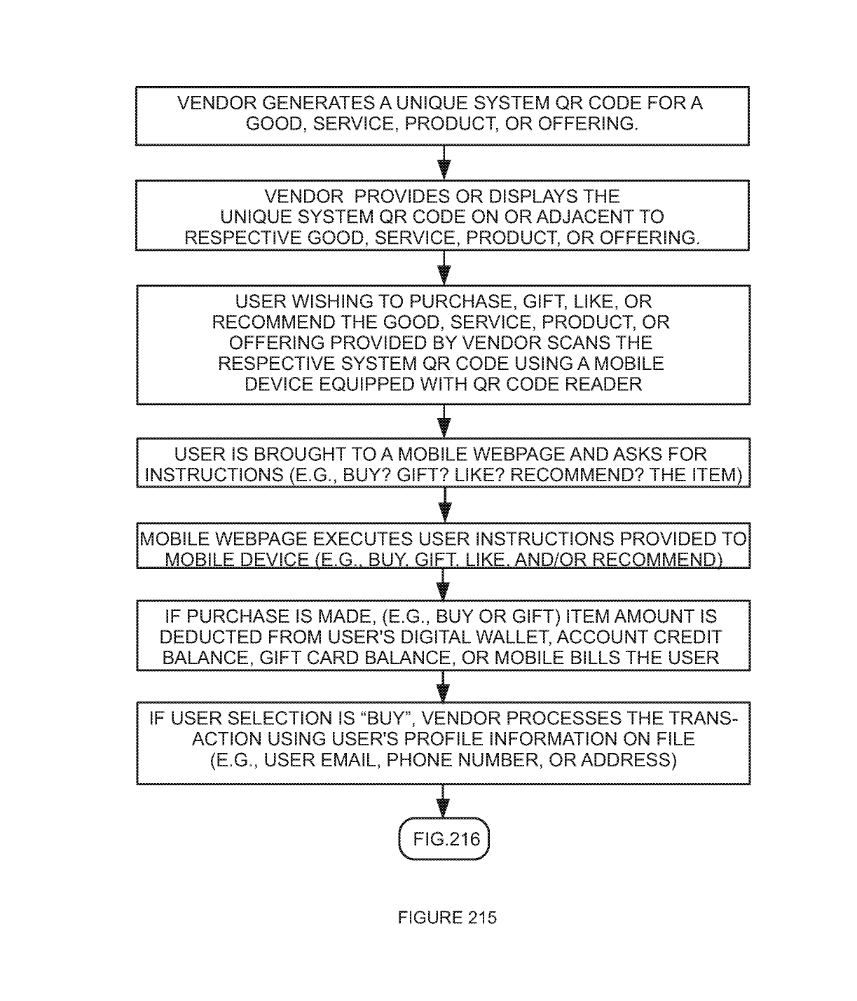

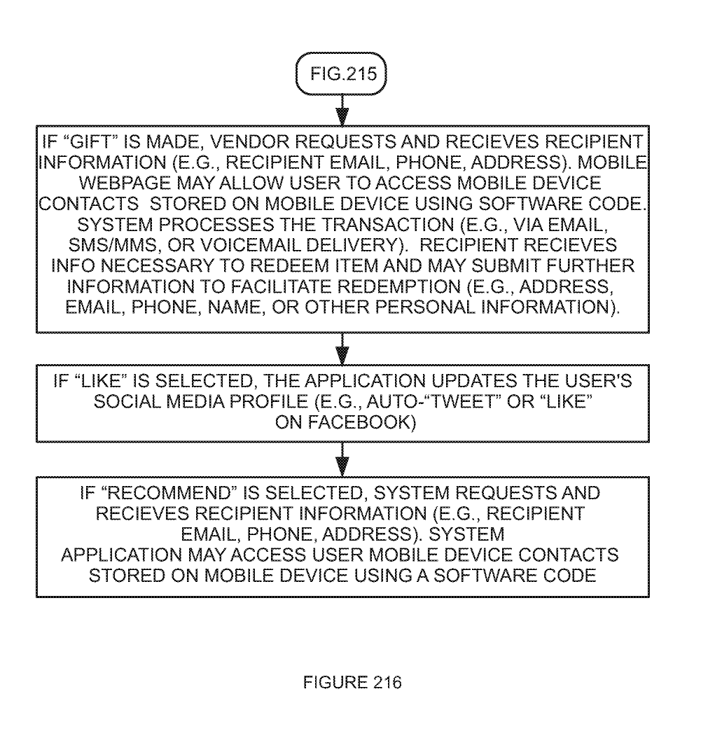

FIGS. 212 and 213 depict a method of providing a system for a user according to some non-limiting embodiments, wherein the system may be used by the user to perform inventive system functions described herein. According to some embodiments, the inventive system functions may be performed externally of the participating entity 65 and/or may be supported by one or more third party servers 125 or system servers 128. According to some embodiments, the participating entity 65 may pay a fee or royalty to the one or more third parties and/or the system for the system-provided services supported by the one or more third party servers 125 or system servers 128, such as a monthly fee or a per-transaction fee, without limitation. FIGS. 215 and 216 depict a method of providing a system for a user to perform the functions described herein according to other non-limiting embodiments, wherein system functions and features describe herein may be performed internally to the participating entity 65 and/or supported by the participating entity 65, for example, entirely on participating entity servers 136. It should be understood that other participating entities, such as social media 93 institutions and/or financial institutions 163 may be involved. For example, social media functions described herein may be performed through a participating entity's social media page, without limitation. For example, functions described herein may be performed through a financial institution's website, without limitation.

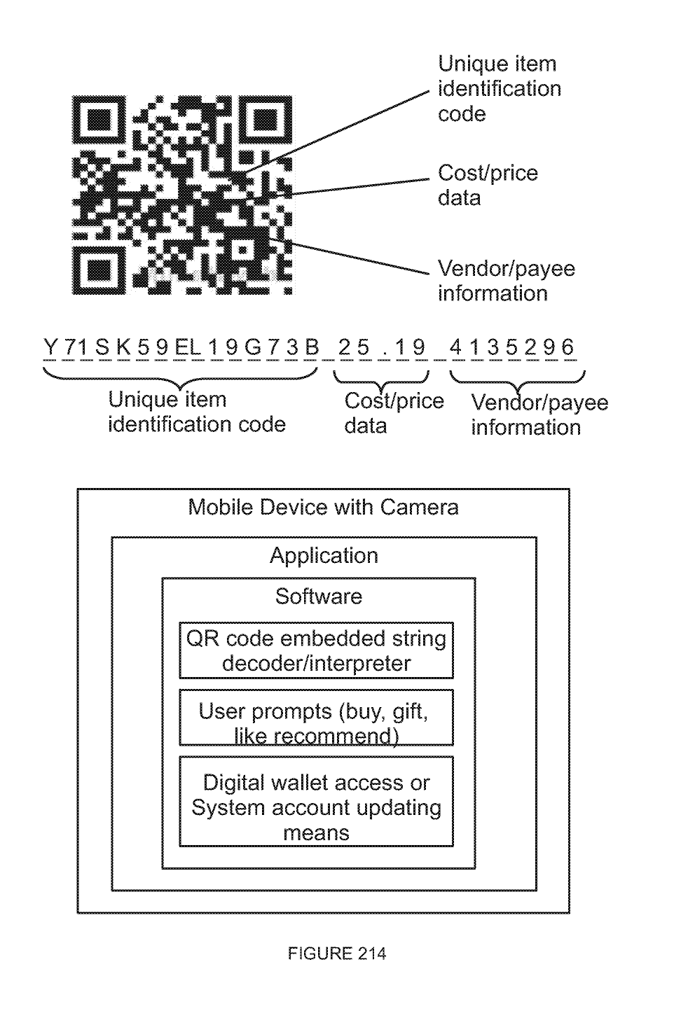

Turning now to FIG. 214, image data 6 disclosed herein may comprise machine-readable indicia. According to some embodiments, machine-readable indicia may comprise information such as item information (e.g., information pertaining to an item, product, good, or service), cost information (e.g., cost information pertaining to an item, product, good, or service), and/or participating entity 65 data (e.g., information pertaining to who sells, manufactures, or provides an item, product, good, or service, such as a system payment address or electronic address of one or more participating entities 65). The information may be contained within a character string in a predetermined order, fashion, or arrangement. The information may be coded in the machine-readable indicia using system software, and the coded information in the machine-readable indicia may be decoded using system software. The information may be encrypted in the machine-readable indicia using system software, and the encrypted information in the machine-readable indicia may be decrypted using system software. In some embodiments, encryption may happen prior to coding the information into the machine-readable indicia. In some embodiments, encryption may happen after coding the information into the machine readable indicia. In some embodiments, decryption may happen prior to decoding the information from the machine-readable indicia. In some embodiments, decryption may happen after decoding the information from the machine readable indicia. Upon scanning the machine-readable indicia with a mobile device 96 having a camera, the information may be received and decoded and/or decrypted by a system application 147 installed on the mobile device 96. The application software 147 may then provide a user with a series of redemption options, for example, by prompting the user to “buy”, “gift”, “like”, “wish”, or “recommend” and displaying one or more options to reply to the prompts on the mobile device 96 display (e.g., displaying respective selectable icons or buttons which may be pressed on a touchscreen of the mobile device 96 as a user input 4; or displaying respective instructions on a screen of the device, wherein a user may reply by pressing one or more buttons on the mobile device 96). Alternatively, in some embodiments, the step of providing a user with a series of redemption options, may comprise prompting the user to “buy”, “gift”, “like”, “wish”, or “recommend” by emitting audio data 7 comprising audio-based instructions, wherein a user may respond to the audio prompts by speaking a reply command, or the user may respond by pressing one or more buttons on the mobile device 96 which pertain to a selected option, without limitation.

In some embodiments, if a “buy” option is selected, the mobile application 147 may access the user's mobile digital wallet to obtain funds to complete the purchase of the item, product, good, or service. Alternatively, system funds or credits associated with the user's mobile device number (e.g., funds associated with the user's mobile device number using the methods described in co-pending U.S. Provisional Patent Application Nos. 61/948,004 and 61/943,376, as well as described herein) may be used to complete the purchase of the item, product, good, or service. Alternatively, the mobile application may have stored user information 8 such as delivery address, billing address information, billing information, financial information (e.g., bank account information, credit card information, debit card information, gift card information, store-accepted credit information, etc.) which may be utilized to facilitate the purchase and delivery of the item, product, good, or service. In this regard, profile 130 information contained within a system database 129 may be utilized to complete the “buy” transaction via the mobile application 147.

In some embodiments, if a “gift” option is selected, the mobile application may access the user's mobile digital wallet to obtain funds to complete the purchase of the item, product, good, or service. Alternatively, system funds or credits associated with the user's mobile device number (e.g., funds associated with the user's mobile device number using the methods described in co-pending U.S. Provisional Patent Application Nos. 61/948,004 and 61/943,376, as well as described herein) may be used to complete the purchase of the item, product, good, or service. Alternatively, the mobile application 147 may access stored user information 8 such billing address information, billing information, financial information (e.g., bank account information, credit card information, debit card information, gift card information, store-accepted credit information, etc.) which may be utilized to facilitate the purchase of the item, product, good, or service. In some embodiments, the stored user information 8 may be stored on the system server 128. In some embodiments, the stored user information 8 may be stored on the user's mobile device 96 which is provided with the mobile application 147. In some embodiments, the user may be prompted to enter recipient information, such as one or more electronic or physical (e.g., mailing) addresses. In some preferred embodiments, an electronic recipient address such as an email address or mobile device number (e.g., phone number) may be provided. In other preferred embodiments, the system application 147 may allow the user to provide recipient information by accessing the user's stored mobile contacts, and allowing the user to select one or more contacts from the user's stored mobile contacts.

In some embodiments, if a “like” option is selected, one or more social media profiles 130′ associated with the user may be simultaneously updated (e.g., a Facebook post, a Twitter feed, a Google+ rating). For example, a favorable opinion which relates to the respective item, product, good, or service may be issued to a profile 130, 130′ of the user upon selecting a “like” option. In some embodiments, the user may independently select one or more social media profiles 130′ which may be linked to the user's system profile 130, via one or more system application 147 prompts. In some embodiments, the one or more system application prompts may only comprise prompts for social media profiles 130′ which are linked to a system profile 130 of the user. In some embodiments, an option to “like” the respective item, product, good, or service on all social media profiles 130′ linked with a system profile 130 may be provided, wherein when selected, the system may provide communications to host servers of each of the respective social media platforms associated with the social media profiles 130′, and the communications may contain information pertaining to the respective item, product, good, or service and the user. In some embodiments, a system profile 130 on a system database 129 may be updated to reflect the liked item, product, good, or service, without limitation.

In some embodiments, if a “recommend” option is selected, the user may be prompted to select one or more mobile contacts or enter one or more recipient electronic addresses (e.g., including, but not limited to email addresses, phone numbers, and social media profile identification numbers or screen names). The mobile application 147 may deliver an electronic message to the selected recipient(s) containing information about the item, product, good, or service associated with the scanned machine readable indicia. For example, in some embodiments, the electronic message may include redemption data 64, instructions on how to purchase, information on where to buy, promotional information, information regarding offers, vendor information, product company information, participating entity 65 information, coupons, use information, various combinations thereof, or the like, without limitation.

Other functions are anticipated, such as a “wish” option, wherein a “wish” option may be provided as a prompt to the user, facilitated by a system application 147, and may be selected by a user, wherein if selected by a user, one or more items, products, goods, or services associated with the machine-readable indicia may be added to a user's shopping list 144, such as a wish list 144a, gifting list, or the like, without limitation. Moreover, an “order” option may be provided, wherein an “order” option may be provided as a prompt to the user, facilitated by a system application 147, and may be selected by a user, wherein if selected by a user, one or more items, products, goods, or services associated with the machine-readable indicia may be delivered to a user's current location (using location-based data), may be delivered to a user's mailing address (retrieved from database 129), or the like, without limitation. Various layers of prompts may be provided to customize a particular system transaction made through a system application 147. It should also be appreciated that kiosks 3 described herein may perform similar functions which may be performed using a mobile device 96 component of the system, without limitation.

While not shown, machine-readable indicia may comprise executable code or instructions for software executions to be made, which may facilitate social media functions such as posting to a wall, recommending, sharing, communicating, or forming a favorable opinion of an item, product, good, or service associated with the machine-readable indicia. For example, the machine-readable indicia may comprise a code representative of a social function (e.g., the vendor/payee information shown in FIG. 214 may comprise multiple pieces of data, for instance, the number “4” shown may mean “like”, “135” may mean “Facebook”, and “296” may represent the vendor's Facebook profile ID number or Twitter page or address e.g., “@McDonald's”), without limitation. Alternatively, a combination of letters “LF” embedded within machine readable indicia may comprise instructions to “like on Facebook”, a letter “G” embedded within machine readable indicia may comprise instructions to “+1” on Google+, and a letter “T” embedded within machine readable indicia may comprise instructions to deliver a Tweet), without limitation. In some embodiments, one or more portions of item codes may represent a vendor ID, or one or more portions of item codes may suggest a vendor's Facebook profile ID number or Twitter page (e.g., “www.twitter.com/vendor”) or address (e.g., @vendor), without limitation. In some embodiments, the machine-readable indicia may comprise embedded “tag” information, for example, a hashtag (e.g., #BigMac), without limitation.

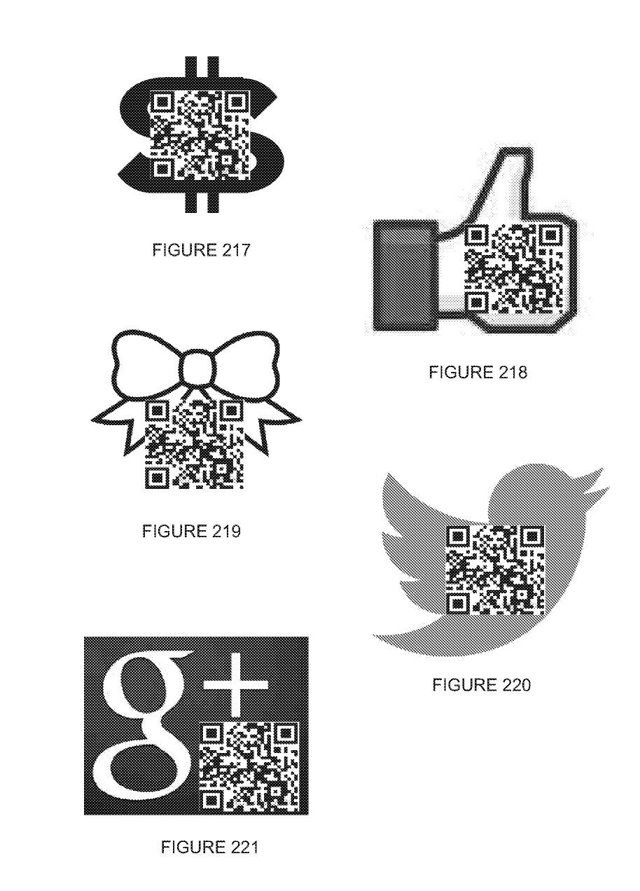

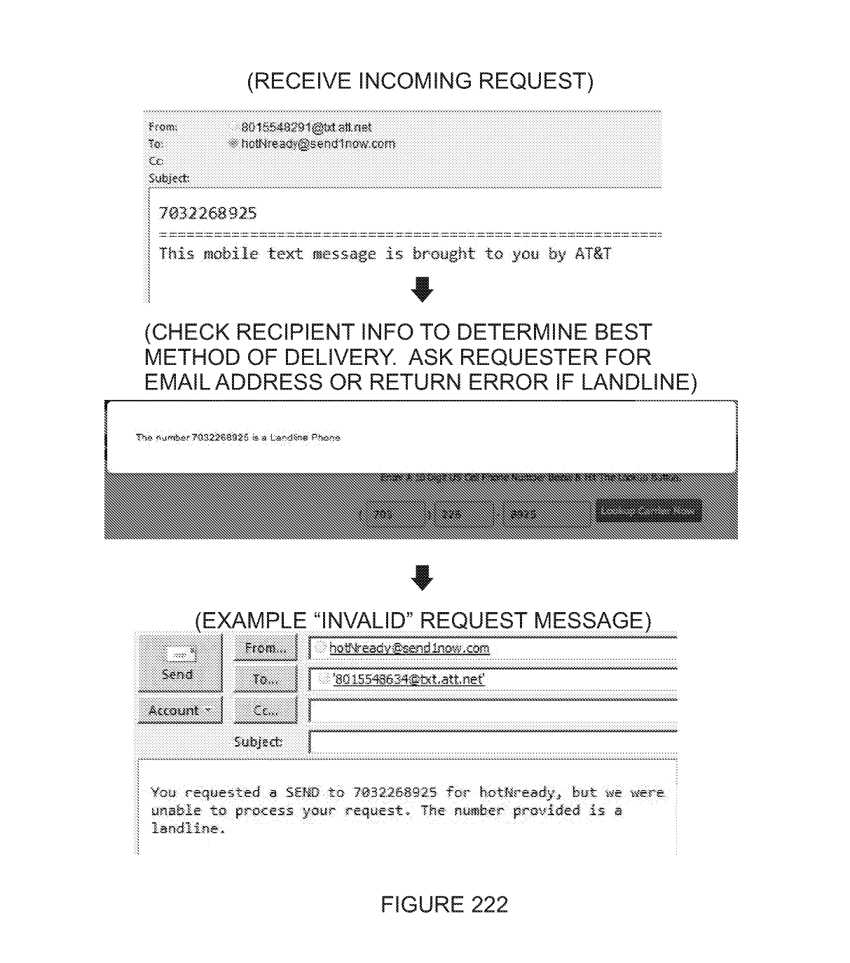

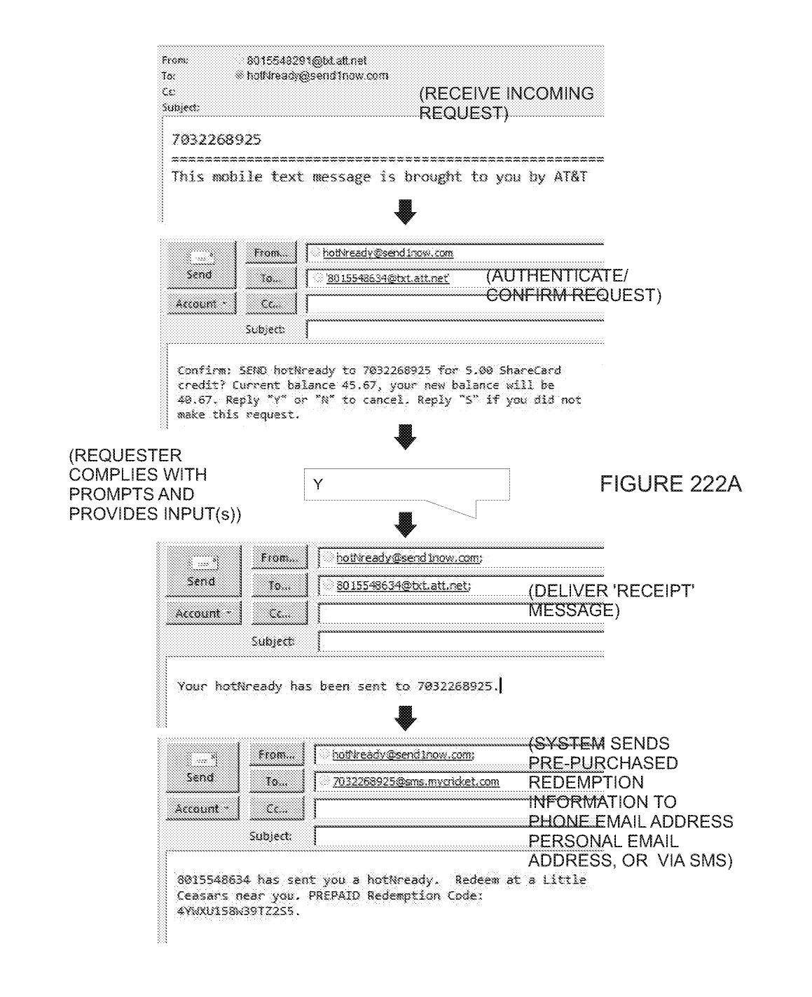

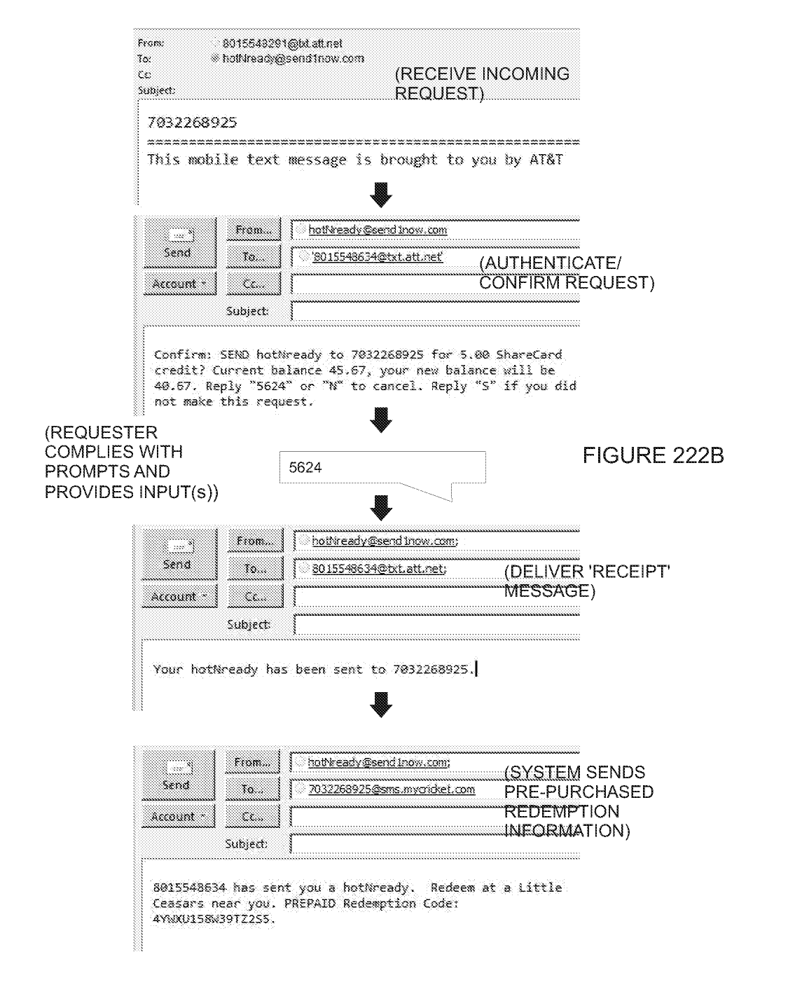

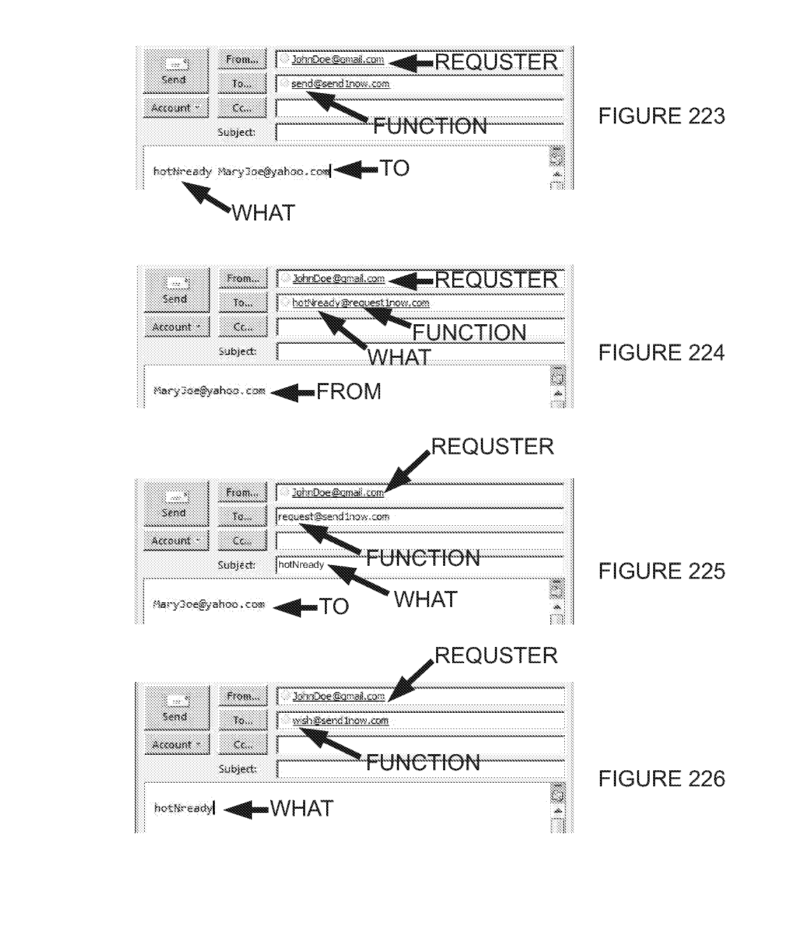

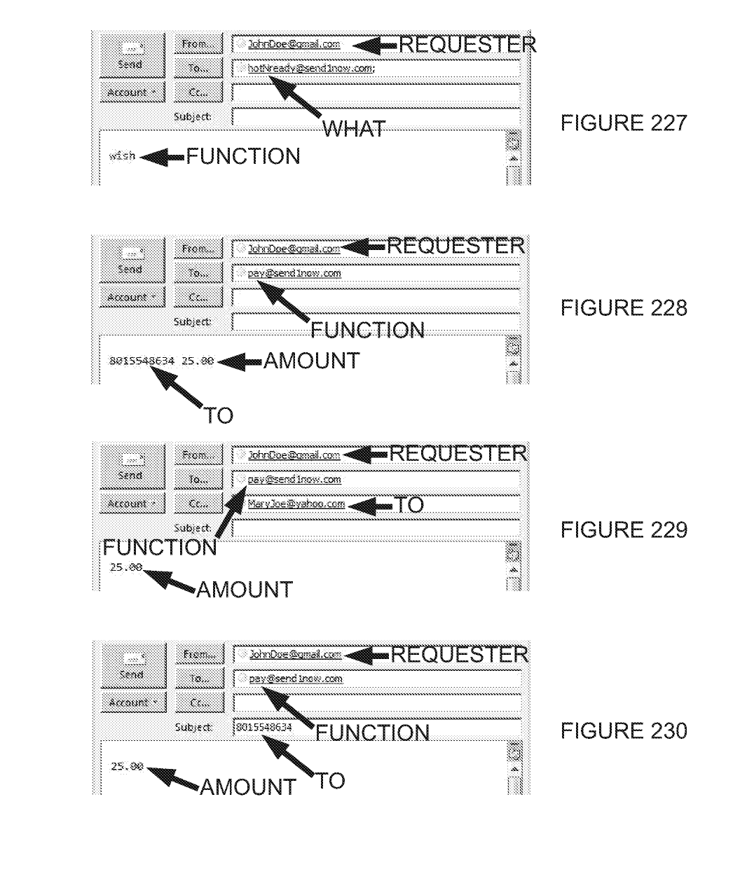

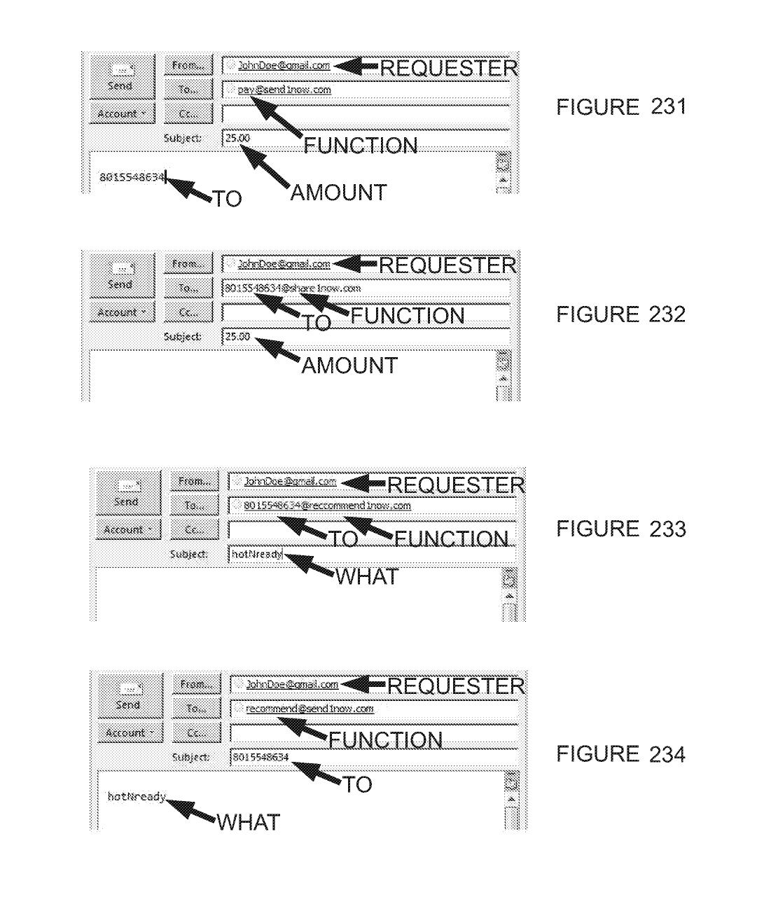

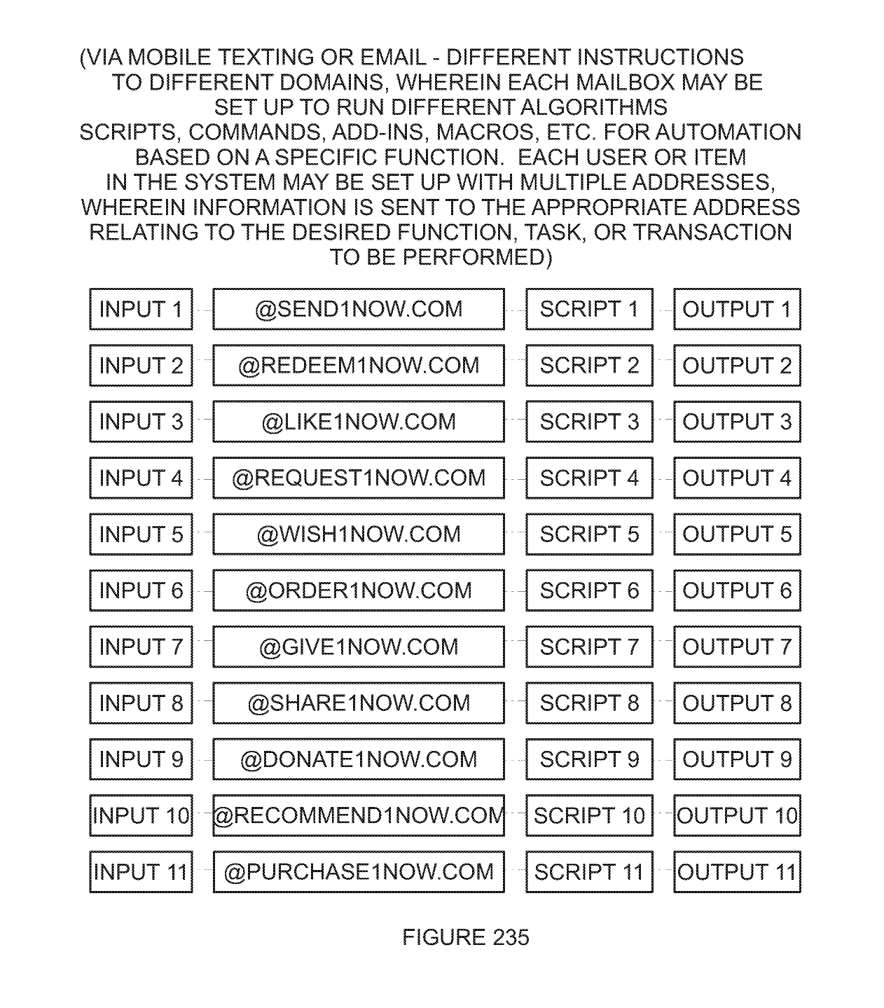

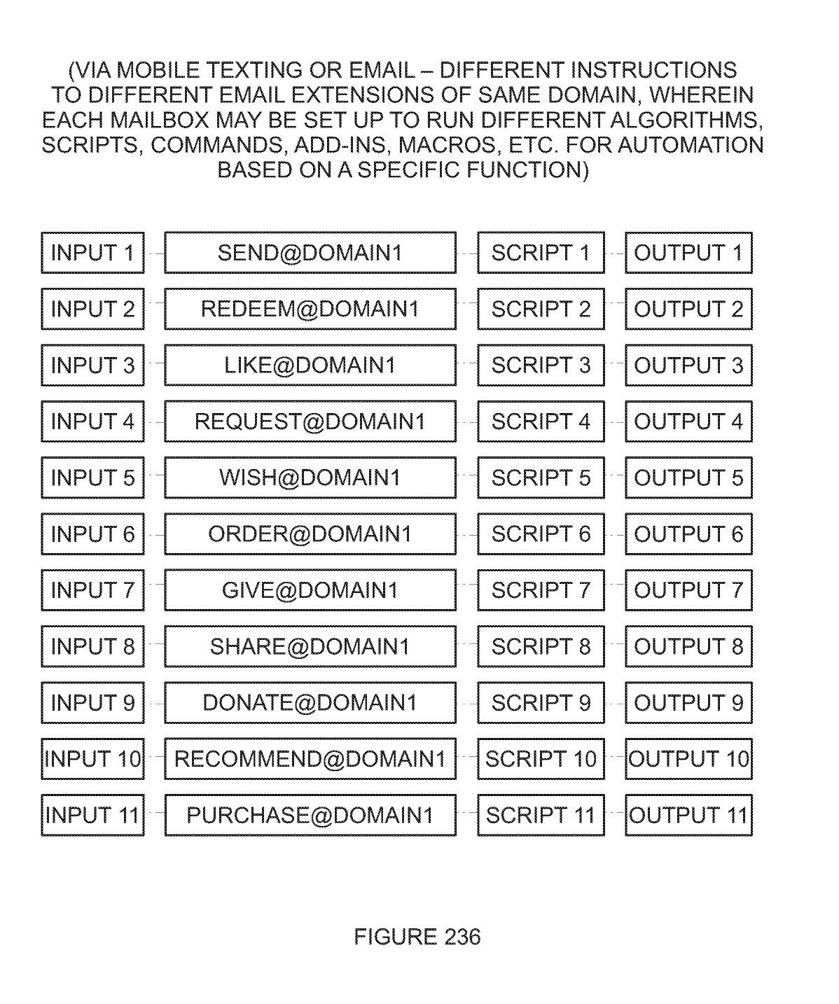

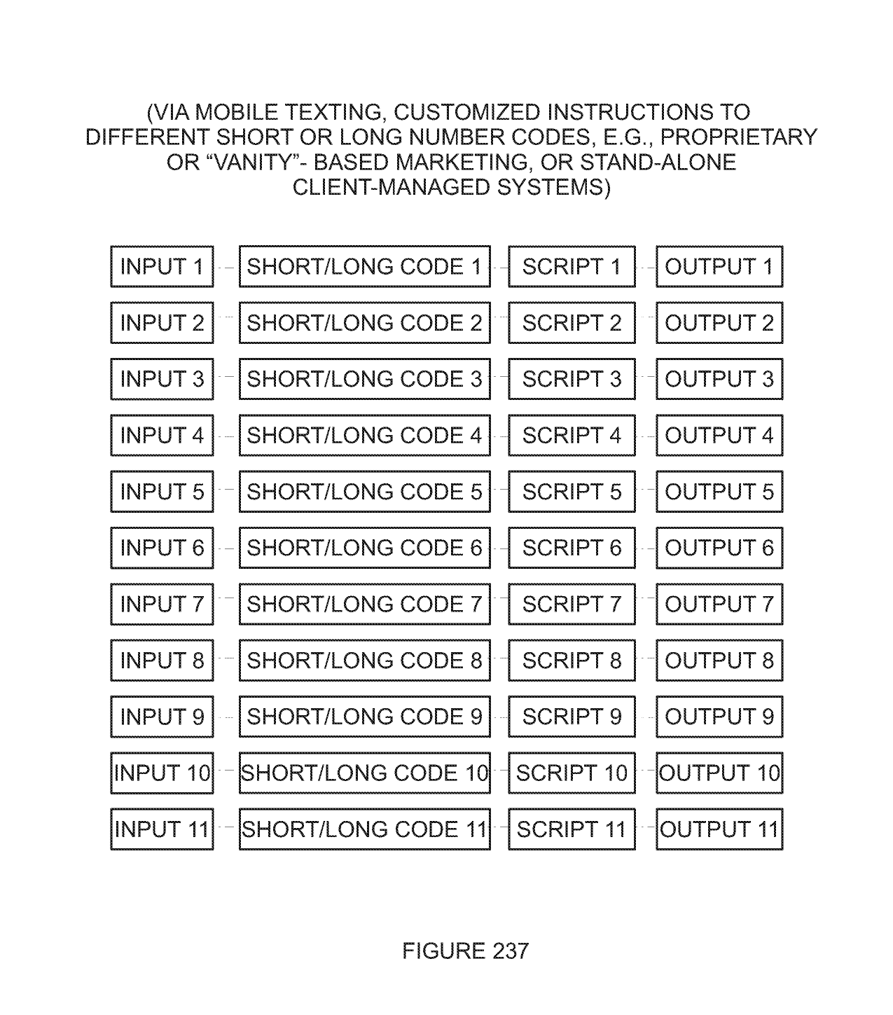

In some embodiments, machine-readable indicia may comprise a color or surrounding indicia which may suggest a particular function to be performed when scanning the machine-readable indicia. For example, functions regarding payment, gifting, liking, wishing, or another meaning or connotation may be employed by the system and/or components thereof. For example, as shown in FIGS. 217-221, a QR code, bar code (1D or 2D), or data matrix code may be provided in the form of a dollar sign (e.g., to suggest buy, purchase, or send/receive funds using system components), a gift with bow (e.g., to suggest gifting to another using system components), and/or a thumbs up (e.g., to suggest a liking function or a function regarding providing a favorable opinion using system components), without limitation. In some non-limiting embodiments, a QR code, bar code (1D or 2D), or data matrix code may be surrounded by indicia to suggest a particular function that may be performed when the machine-readable indicia is scanned using a system application 147, kiosk 3, or other equipped system component 95. In some embodiments, a QR code, bar code (1D or 2D), or data matrix code may be superimposed on, or otherwise surrounded by other indicia which might suggest a particular function that may be performed when the machine-readable indicia is scanned using a system application 147, kiosk 3, or other equipped system component 95. In this regard, a user may, in some embodiments, readily identify what might happen when the indicia is scanned using a system component, such as a system application 147, kiosk 3, or other equipped system component 95. Such indicia may be provided to signs, displays, computer screens, television screens, tablet screens, advertisements, pamphlets, brochures, packaging, vehicle wraps, receipts, tags, labels, printed matter, and/or other physical objects and articles, without limitation.

AOL Instant Messenger (AIM) version 5.2 and above, which has support for sending SMS messages for free, may be utilized with components of the system to perform or otherwise facilitate receipt and/or delivery of messages to or from users. ICQ has support for sending SMS messages at no cost, and may be advantageously employed, as well.

Microsoft Outlook 2007+ has native support for sending SMS messages worldwide via the Outlook Mobile Service. Off-the shelf or proprietary developed plug-ins and/or scripts written for Microsoft Outlook, may, in some embodiments, be employed to add to functionality and fully automate the inventive systems and methods described herein. Such plug-ins/add-ins, scripts, macros, software code modules, and/or the like may utilize the SMS gateways of aggregators or mobile operators, without limitation. Commercial or developed software may be incorporated to perform algorithmic logic and execute functions that might otherwise need to be performed manually. In this regard, the systems and methods described herein may be scalable to accommodate user growth, increasing frequency of use of the system, and larger traffic/volume, while minimizing manual data entry and manipulation of files and data, in any manner known in the art.

Skype, which has support for sending SMS messages (as well as means for communicating audio data 7 and image data 6 to mobile devices 96 and computing devices 95), may be integrated with various components of the system, without limitation. In some embodiments, a user may link their Skype electronic address to their system profile 130 and perform functions described herein using Skype. Windows Live Messenger, MSN Messenger, Windows Live Messenger 7.0 and up have support for SMS messages, and may be incorporated into the system to improve functionality. Yahoo! Messenger, which may be accessible through a dedicated client application, or through a web site (mail.yahoo.com) has support for SMS messages, and may be incorporated into the system to improve functionality. These and other systems which support SMS interfaces and/or which may have the ability to process and handle transactions, along with programs like Microsoft Excel and/or other data entry/database software may be separately used, or used in combination with each other to provide a seamless system integration across multiple platforms. Proprietary software code and other executables may be written to enhance integration and improve synergies between dissimilar programs. It is not the intent of the present application to limit the novel systems, methods, and apparatus disclosed herein to a particular preferred embodiment of performing the operations and functions described.

Simple or advanced string or array searching, manipulating, storage, and indexing algorithms, code, source code, executables, operators, compilations, compilers, interpreters, languages, lexical analyzers, grammars, expressions, data structure builders, add-ins, plug-ins, macros, semantics, translation software, voice-to-text software, text-to-voice software, syntax, pragmatics, parsers (e.g., top-down, recursive descent, Left-to-right—Leftmost derivation/LL, Earley, bottom-up, precedence, bounded context/BC, Left-to-right—Rightmost derivation/LR, simple LR/SLR, LALR, Canonical LR/LR(1), GLR, CYK, recursive ascent, chart, and the like), look ahead parser actions, backtracking, deterministic parsing, database to email PHP server-side scripting, email to database PHP server-side scripting, database to SMS PHP server-side scripting, SMS to database PHP server-side scripting, and/or other mechanisms or programming instruments may be utilized to scan incoming messages for relevant data, extract relevant data necessary to process a transaction (e.g., the electronic address identification of a requester, the electronic address identification of one or more recipients, information regarding an amount of funds or credits to be transferred to the one or more recipients, information regarding one or more items/products/goods/services to be sent, information regarding one or more items/products/goods/services to be added to a wish list, information regarding one or more items/products/goods/services to be liked via social media institution/application/website, information regarding one or more items/products/goods/services to be recommended, information regarding one or more items/products/goods/services to be added to a wish list, and similar transactional information, without limitation).

Moreover, mechanisms and/or programming instruments may be advantageously utilized to import, export, manage, adjust, manipulate, extract, process, or perform other functions using relevant data, whether the relevant data is electronically-stored, accessed, and utilized in digital format or manually accessed and utilized. Mechanisms and/or programming instruments may be advantageously employed and/or utilized as necessary with the relevant data to process a transaction, and update a system database 136, 129 as conventionally done in electronic commerce. Various “off shelf” email automation software solutions (e.g., email-to-database, database-to-email, database-to-SMS/MMS, SMS/MMS-to-database), such as PHP-POP3 email to MySQL, may be employed in any manner consistent with the spirit of this disclosure, to facilitate and/or complete some, all, or portions of functions described herein, without limitation.

For example, software 147 used by various components of the system may be configured to modify the database 129 and may be executed in various forms to update or modify the database 129 (e.g., by “moving numbers” around the database, crediting certain individuals or parties to transactions by modifying profile 130 information, debiting certain individuals or parties to transactions by modifying profile 130 information, adding or subtracting information from one or more portions of the database including tables containing user/participating entity 65 profile 130 information, automatically adding electronic addresses (e.g., email addresses or short codes, without limitation) to the system database 129 upon participating entity 65 participation or user 91, 92 request, and/or performing automated sequences typically utilized for banking transactions, electronic commerce transactions, and marketing transactions—such as mobile and online-based transactions, without limitation).

According to some embodiments, automated email to database parsers, database parsers, xml to database parsers, and the like (e.g., Excel/Access-based or other platform database parser/parsing software) may be incorporated, without limitation. Such software may be utilized to automatically generate *.txt,*.html, or other-formatted messages between system users (e.g., senders/sending users, recipient users, redeeming users, reimbursing users, participating entities 65, etc.) and between system components (e.g., mobile devices 96, computing devices 95, cards 19, kiosks 3, payment terminals, system software 147, system-integrated servers 122, 128, 136), as well as execute various instructions to components. For instance, software used with the system may, in some embodiments, automate data collection from and/or the extraction of all or portions of certain character strings from any portion of “from” fields, “subject” fields, “to” fields, “body” fields, and/or the like, as necessary to facilitate a transaction. Data entry protocols and/or software (e.g., macros) may be advantageously employed and utilized to receive, decipher, enter, arrange, manipulate, extract, export, import, and deliver, such information to a database from incoming received electronic communications (including messages and web submissions). Data entry protocols and/or software (e.g., macros) may also be employed and utilized to receive, decipher, enter, arrange, manipulate, extract, export, import, and deliver, such information from a database to outgoing electronic communications (including messages and web submissions). Software may be used to perform selections from files or folders on local, external, or remote hard drives or “clouds”; may be used to attach files, may be used to copy and paste (or otherwise directly import) character strings from one location to another location (e.g., from an incoming SMS/MMS/mobile/email message to a database or from a database to an outgoing SMS/MMS/mobile/email message), may be used to package and deliver “canned” pre-vetted or predetermined messages, may be used to manipulate spreadsheet cells (e.g., by identifying row/column information in the source code), etc., without limitation. The exact types or brands of software, exact combinations of hardware, and/or exact syntax used may not be important, so long as the most basic functions of the inventive methods described can be successfully implemented, whether in crude form or polished and efficient form.

Some non-limiting examples of types of algorithms/code/language/syntax which may be used to parse or scan portions of a message from a sending user (particularly to extract spaces or extraneous characters within a received string, for example, to extract a recipient phone number) may comprise algorithms/code/language/syntax similar to what is shown in priority U.S. Provisional Patent Application No. 61/978,998, priority U.S. Provisional Patent Application No. 61/981,779, priority U.S. Provisional Patent Application No. 62/009,149, and/or priority U.S. Provisional Patent Application No. 62/012,343, without limitation. It should be noted that similar code or algorithms could be used to look for and extract email addresses (e.g., by looking for the “@” symbol and applying front/back whitespace cutoff algorithms as necessary), could be used to look for and extract recipient addresses, could be used to look for and extract vendor ID numbers, be used to look for and extract item numbers (e.g., 8, 12, 13, or 14-digit UPC codes), could be used to look for and extract recipient responses (e.g., commands or function codes), could be used to look for and extract redemption information 64 (e.g., identify one or more items, products, goods, or services to be regifted, voided, or the like), and/or could be used to properly format received text, including messages and physical or shipping address information, without limitation. Software containing algorithms/code/language/syntax could be proprietarily developed and coded, or could be purchased off-shelf and integrated with system components, without limitation. It should be understood that many other parsing methods, syntactic analysis methods, and/or processes or computer science techniques known in the art, which may not be described in detail herein, but are configured to similarly analyze data and perform similar functions may be utilized, without limitation. All or portions of one or more strings containing symbols, characters, text, or alphanumeric information from incoming and outgoing communications may be used and parsed by system components using any automated solution currently available in the art, without limitation, for example, to improve upon efficiency and reduce the amount of reliance on human intervention and/or manual data entry.

In some embodiments, text messages may be sent from a computer 95 to a mobile device 96 via an SMS gateway, for example, using a robust and/or popular email client program, such as Eudora, Thunderbird, or the like. In some embodiments, messages may, be sent in ASCII “text-only” mode to accommodate existing technologies and/or eliminate the chances of incompatibility with HTML formats. According to some embodiments, SMS/MMS methods utilized in mobile banking, SMS/MMS notification methods utilized in mobile marketing, SMS/MMS-based text voting/televoting methods, and the like may be incorporated or otherwise utilized to various extents to accomplish the methods and functions described herein, without limitation.

In some embodiments, before a message is sent to an electronic address by a system component, the system may determine or verify the domain of the mobile carrier's SMS gateway. Verification may be performed using a 10 digit mobile device number received from an incoming communication made to the system. For example, if the system receives a text message request communication from 703888888@vtext.com in the form of an email (e.g., where a user sends a text message to a system electronic address comprising an system email address), and in the body of the email, a ten digit recipient number “4151234567” exists, the system may determine or verify the carrier of the ten digit recipient number “4151234567” manually or automatically, via software/API, before sending an email to the ten digit recipient number “4151234567”. In some embodiments, a system component (such as a system employee or system software) may index through a database comprising up-to-date carrier information in order to determine the appropriate carrier email extension (e.g., in order to determine the correct carrier extension of the ten digit recipient number “4151234567”). In some embodiments, the database may be located on a system server 128, or in some embodiments, the database may exist on an external server 125. Websites and databases currently exist, which can be used to readily identify any phone number and/or provide its carrier, from which an appropriate email extension (e.g., “@vtext.com”) may be determined. In some embodiments, if an email extension of a mobile number is unknown, a system script or program may comprise code that automatically sends an email comprising redemption information to each possible carrier permutation (e.g., Sprint, Verizon, T-mobile, etc), wherein emails addressed and sent to incorrect email addresses (i.e., email addresses with an incorrect carrier extension) may be returned or “bounced”. In some non-limiting embodiments, a Line Identification Append service for US and Canadian numbers that handles local number portability may be used, without limitation. Such services may be available as a SOAP API which may be integrated with system software 147. Alternatively, such services may be available as a batch service; wherein the system may send the service a file containing one or more recipient mobile numbers, the service may process the information in the file, and the service may send a reply to the system containing a list of valid email addresses or valid carriers pertaining to the mobile numbers back to the system, preferably, automatically. Besides identifying a carrier, such services may identify a line type (wireless, landline, etc.) associated with a mobile number, may identify whether the number has been ported or not, and/or may possibly identify geographic information, such as address or caller identification information. The system may use this information, for example, to populate profile 130 information into a system database 129. In some instances, code may be written in any language to interface with third party services such as FoneFinder, without limitation.

In the provided example, the unknown carrier number (e.g., “4151234567”) may be run through this process manually or automatically to identify its current carrier (e.g., AT&T). With correct current carrier information, the system: may add the recipient-provided number “4151234567” to the correct carrier extension handle “@txt.att.net” (or “@mms.att.net” for MMS messages), may store the combination into a variable, may populate the variable into a system database 129, and/or may provide the variable (i.e., “4151234567@txt.att.net”) into the “To:” field of a new email. The new email may be sent to the recipient's phone via SMS or MMS (assuming 703888888@vtext.com has the appropriate sufficient funds or credits affiliated with its respective system account balance. Sufficient funds or credits may be determined, for example, by accessing the system database 129 and checking the “balance” column associated with row “703888888@vtext.com” or the like. The balance information may be compared with the request communication in order to determine if the transaction should be completed or not. In some embodiments, the system may text an SMS message (in a non-email format) to a mobile number (e.g., “4151234567”) to ensure proper delivery of a message containing redemption information to a recipient. In some embodiments, the system may request input from a recipient (e.g., “703888888 has sent you ‘X’, Do you wish to accept? Reply ‘Y’ or ‘N”). In this regard, the recipient may reply with user input 4 (e.g., ‘Y’ or ‘N”), and the incoming message may reveal the proper carrier information and/or verify an electronic address. Once a number is in the system database 129, such electronic address verification steps may not need to be performed again.

In some embodiments, the system may access a database filled with pre-paid vouchers from various vendors, companies, or the like, and may select the appropriate barcode image (MMS) and/or redemption code (SMS), which may be pre-vetted and/or provided by the vendor. After selecting the appropriate redemption information 64 which is related to the item number provided by the sender (7038888888@vtext.com), the system may perform a copy and paste function and deliver a message containing the proper redemption information 64 to the recipient (e.g., “4151234567”). The recipient may then use/redeem the delivered redemption information 64 at the respective participating entity 65 (e.g., in-store, or online). According to some embodiments, the system may be set up to receive request communications to the system, and upon receipt of a request communication, may be configured to send a user sending the request communication, a one-time pass code or PIN; for example, upon use/redemption of redemption information 64. In this regard, the system may be provided with means for ensuring that a recipient is a bona-fide recipient of the redemption information 64 used/redeemed. In some embodiments, a one-time pass code or PIN may be assigned to a user's electronic address (e.g., “4151234567@txt.att.net”, “4151234567”, “4151234567@gmail.com”, or “@4151234567”, without limitation). In some embodiments, a one-time pass code or PIN may be delivered to a user's electronic address with redemption information 64 in an electronic message (e.g., in a single electronic message sent to a recipient user, for example, via electronic mail). In some embodiments, one or more databases 136 of one or more participating entities 65 may be provided with one or more one-time pass codes or PINs in advance (e.g., to compare with one-time pass codes or PINs provided by users during use/redemption of redemption information 64). In some embodiments, an “approved request” or “confirmation” electronic communication may be sent to a participating entity 65 system component. For example, in some embodiments, an “approved request” or “confirmation” electronic communication may be sent to a participating entity's mobile device 96 (e.g., via text message to the participating entity, an email to the participating entity's email client, a phone call to the participating entity, a social media post to the participating entity's profile 130′, and/or a voicemail of the participating entity's inbox, without limitation), and/or an “approved request” or “confirmation” electronic communication may be sent to a participating entity's computing device 95 (e.g., such as a payment terminal, wherein an electronic communication comprising confirmation data or instructions may be sent to and displayed by a user interface 106 of the payment terminal). In some embodiments, an “approved request” or “confirmation” electronic communication may be sent to a participating entity's computing device 95 (e.g., via text message to the participating entity, instant message to the participating entity, an internet-based (e.g., VoIP) voice call or video chat call, an email to the participating entity's email client, a phone call to the participating entity, a social media post to the participating entity's profile 130′, and/or a voicemail of the participating entity's inbox, without limitation). In some embodiments, a one-time pass code or PIN may be entered into the payment terminal of the participating entity, via a user interface 106, wherein upon entry of the one-time pass code or PIN (and optionally the redeeming user's electronic address information and/or redemption information 64), system software 147 associated with the payment terminal (e.g., “client” component) may communicate with the system database 129 and/or the participating entity's database 137 comprising the one-time pass code or PIN; and wherein if the one-time pass code or PIN is valid (or otherwise associated with with the redeeming user's electronic address information and/or redemption information 64), the redemption information 64 may be authenticated, without limitation.

Other methods of communication to and from system components which may be used to notify the participating entity 65 that a transaction is valid/authenticated may be utilized, without limitation. In some embodiments, a one-time pass code or PIN may be one of a plurality of pre-vetted one-time pass codes or PINs; for example, which may be known by only the participating entity 65 (e.g., on a participating entity 65 server 136 database 137) and the system (e.g., on a system server 128 database 129). According to some embodiments, the one-time pass codes or PINs may be heavily guarded and/or periodically updated/changed (e.g., on a daily basis). According to some embodiments, a participating entity 65 may login to the system website 127, request updated one-time pass codes or PINs for some or all of their affiliated or accepted redemption information 64, and then print out the updated one-time pass codes or PINs, for example, for POS checkout employees to reference. According to some embodiments, a participating entity may login to the system website 127, may request updated one-time pass codes or PINs for some or all of their affiliated or accepted redemption information 64, and then download a file containing the updated one-time pass codes or PINs to a database 137 stored on the participating entity's server 136 for use with the participating entity's computing devices 95 (e.g., payment terminals). In some embodiments, the downloaded file may contain one-time pass code or PIN information, redemption information 64 associated with the one-time pass code or PIN information, and/or user data 8 such as one or more electronic addresses associated with the one-time pass code or PIN information and/or the redemption information 64, without limitation. In some embodiments, the system may send an electronic message (e.g., an SMS message, without limitation) to a recipient of redemption information 64, the electronic message containing a one-time pass code or PIN (e.g., which may match one of many one-time pass codes or PINs previously received or received in real-time by the participating entity 65, for example, which may match one of many one-time pass codes or PINs previously received by the participating entity 65 upon the step of requesting updated PIN codes), and a POS checkout employee may compare the one-time pass code or PIN contained in the electronic message against a previously printed out list of updated one-time pass codes or PINs to see if there is a match. Alternatively, software 147 provided to the P-O-S checkout terminal may compare the one-time pass code or PIN contained in the electronic message against a previously downloaded file of updated one-time pass codes or PINs (e.g., stored in the participating entity's database 137 on the participating entity's server 136) to see if there is a match. If one or more matches exist, the participating entity 65 may honor redemption information 64 provided by the recipient.

In some embodiments, redemption information 64 delivered to a recipient may comprise image data, such as indicia, a QR code, a data matrix code, a 1D barcode, and/or a 2D barcode, without limitation. A participating entity 65 may scan the image data with a mobile device 96 comprising a system-integrated mobile application 147, and/or may scan the image data using reader means and a system-integrated application installed on the participating entity's computing device 95 (e.g., payment terminal). For example, in some non-limiting embodiments, the mobile device 96 may comprise a cellular phone device provided adjacent the POS checkout terminal which may be accessed and operated by a POS checkout employee. In some embodiments, the POS checkout employee may scan a recipient's mobile device 96 screen which may be displaying the redemption information 64 image data. In some embodiments, the mobile application 147 may instantly update the system database 129 to reflect a use/redemption of redemption information 64 and may remove or delete the used/redeemed redemption information 64, may change a status of the redemption information 64 (e.g., from “active” to “void”), may move the redemption information 64 (e.g., from one database table comprising unused redemption information to another database table comprising used redemption information), or the like, without limitation. In some embodiments, a step of updating the system database 129 to reflect a use/redemption of redemption information 64 may comprise deducting credit from one's system profile 130 account balance (e.g., debiting the recipient's account). Consistent with the aforementioned example, in some embodiments, a system account balance (e.g., an account balance affiliated with “703888888@vtext.com”) may, for example, be deducted upon a use/redemption of redemption information 64 sent to a recipient (e.g., a recipient having an electronic address of “4151234567@txt.att.net”), without limitation; wherein a user who gifts redemption information 64 to others may, in some embodiments, only be charged for the gifted redemption information 64 if/when the gifted redemption information 64 is used to redeem actual items, products, goods, or services in exchange for the gifted redemption information 64.

Alternatively, a participating entity 65, using a mobile device 96 provided adjacent a POS terminal may electronically communicate (e.g., text or email) redemption information 64 (such as one or more redemption codes), one or more delivered one-time pass codes or PINs, and/or one or more redeeming user electronic addresses, to a system electronic address (e.g., redeem@GOsend1.com, in the non-limiting case of an email electronic communication). The electronic communication may be received by a system component (e.g., a server 125, 128 hosting a system email client in the non-limiting case of an email electronic communication). For example, in a non-limiting case, an email electronic communication may be received to a system email inbox; wherein the email may be manually read (e.g., by a system employee) or it may be automatically read (e.g., by scripts or plug-ins in an automated fashion); wherein information contained within the email may be extracted and/or parsed; wherein redemption information 64 contained within the email may be identified; and/or wherein the identified redemption information 64 may be automatically deleted from a profile 130, for example, a profile 130 of a user associated with the redemption information 64, one or more delivered one-time pass codes or PINs, and/or one or more redeeming user electronic addresses, contained within the email electronic communication (e.g., a respective recipient (“4151234567”) of redemption information 64 using/redeeming redemption information 64 with the participating entity 65). Software 127 within the system may search through the system database 129 to look for the identified redemption information 64 within the system database, and may eliminate matching redemption information 64 from the system database 129 or may otherwise void or alter the redemption information 64 (e.g., marking a change in status of the redemption information 64 or location of the redemption information 64 within the database 129), since the redemption information 64 has been used/redeemed. In other words, once credit or value associated with redemption information 64 is depleted, a system database 129 may be changed to reflect the same. It should be understood that in some embodiments, the system database 129 may comprise one or more system-integrated databases 129, 135, 137, 138, without limitation.

In some embodiments, the creation and/or delivery of electronic messages from the system to senders and/or recipients may be made by system components comprising mobile devices 96 (e.g., cell phones). In some embodiments, the creation and/or delivery of electronic messages from senders and/or recipients to the system may be made by system components comprising mobile devices 96 (e.g., cell phones). In some embodiments, there may be little or no need for system components to determine a mobile device 96 number's email equivalent electronic address. In some embodiments, there may be little or no need for system components to determine a carrier handle or carrier extension (e.g., “@vtext.com”, “@myboostmobile.com”, “@cspirel.com”, @sms.mycricket.com”, “@mymetropcs.com”, “@messaging.sprintpcs.com”, “@tmomail.net”, “@email.uscc.net”, etc.) of a recipient, for example, based on system-received recipient information (e.g., a mobile device 10 digit phone number) alone. For example, in some lesser desired “crude” or “most simplistic” embodiments (e.g., where few user transactions are expected to be performed within a period of time), the system may simply comprise: 1) a mobile device 96 (e.g., a smart phone with internal and/or external storage, the ability to make and/or send calls, voicemails, emails, social media posts, video chat requests, SMS/MMS/mobile messaging communications, and/or the like, without limitation), and 2) an application 147 (which may be an application installed on the mobile device 96) which can access a database comprising redemption information 64; wherein an individual representing the system may manually receive an incoming system user electronic communication request (e.g., an SMS message-based system user request sent to the mobile device's 96 electronic address and received by the mobile device 96) via the mobile device 96, the request comprising a recipient electronic address (e.g., an intended recipient's phone number); and wherein the individual representing the system may interpret incoming system user electronic communication request; and wherein the individual representing the system may manually select appropriate redemption information 64 pertaining to the incoming request from the database, and may manually paste it into a new electronic communication addressed to the recipient electronic address (e.g., the intended recipient's phone number); and wherein the individual representing the system may manually send the redemption information 64 to the recipient (e.g., by sending a text message to the intended recipient's phone number, the text message containing the redemption information), without limitation. According to some embodiments, the database may comprise memory or storage on the mobile device 96, without limitation. According to some embodiments, the database may be a database stored on an external server 125 which is accessible by the mobile device (e.g., via a data communications network 118), without limitation. According to some embodiments, the database may be located on an external drive operably connected to the mobile device 96, without limitation. In some embodiments, the database may comprise a contacts list. In some embodiments, information regarding transactions made in this manner may be recorded electronically on the mobile device, or may be handwritten in a paper ledger, without limitation. In some embodiments, the mobile device 96 may be configured to enable an individual representing the system to: look up redemption information 64 associated with a requested item, product, good, or service to be purchased and sent to a recipient; look up a recipient and/or sender 10 digit phone number; if necessary, create a new recipient account (e.g., create a new contact in a contacts list of the mobile device 96) from recipient information contained within a received message (e.g., an incoming request message to deliver redemption information 64 pertaining to funds, credits, one or more items, one or more products, one or more goods, and/or one or more services); look up and determine a credit balance of an account of the sender of an incoming request (e.g., an account associated with an electronic address used to send an incoming request); reduce the sender's account balance by an amount (e.g., an amount equivalent to, an amount approximately equivalent to, an amount more than, or an amount less than) associated with a monetary value of redemption information 64 to be sent to a recipient; adjust sender and/or recipient account balances for fees, applicable taxes, etc.; select from a list of “canned” redemption information 64 (e.g., contained within a database or file of redemption information 64 which may be used at a participating entity to obtain an item, product, good, or service in exchange for the redemption information); attach the appropriate respective redemption information 64 to an electronic communication (e.g., a voice message, an email, an SMS/MMS/mobile message/text message, a social media post, a mobile application submission, etc.) which is intended for the recipient; and/or send the electronic communication (e.g., electronic message) containing the attached appropriate respective redemption information 64, to the recipient, without limitation. In other words, in some embodiments, the system may be thought of as acting as a “middleman” between one or more end users, to facilitate one or more transactions between the one or more end users, via a network 118 (e.g., a network comprising at least a cellular network), without limitation. In some embodiments (such as the one described above), it may be possible for end users to make transactions and/or for system components to process transactions, with simple access to a cellular network, for example, without substantial use of an internet connection. In some embodiments, outputs 5, functions, and/or executions (e.g., conversions, calculations, logical algorithmic processing, and the like, etc.) may be performed manually (e.g., by an individual representing the system) or automatically (e.g., using system software 147) using information provided by one or more sender users and/or by one or more requester users. According to the most simplistic embodiments (e.g., the process described above in this paragraph which has been made to disclose a very simplistic non-limiting embodiment) the system may be configured to be simple enough so as to allow inventive system features and concepts to be realized with very few components (e.g., a residence or small office, a single individual representing the system as a system entity, and a mobile device 96). It should therefore be readily appreciated by those having an ordinary skill in the art that the inventive features and methods may be scaled in a variety of different manners, without departing from the scope of this disclosure.

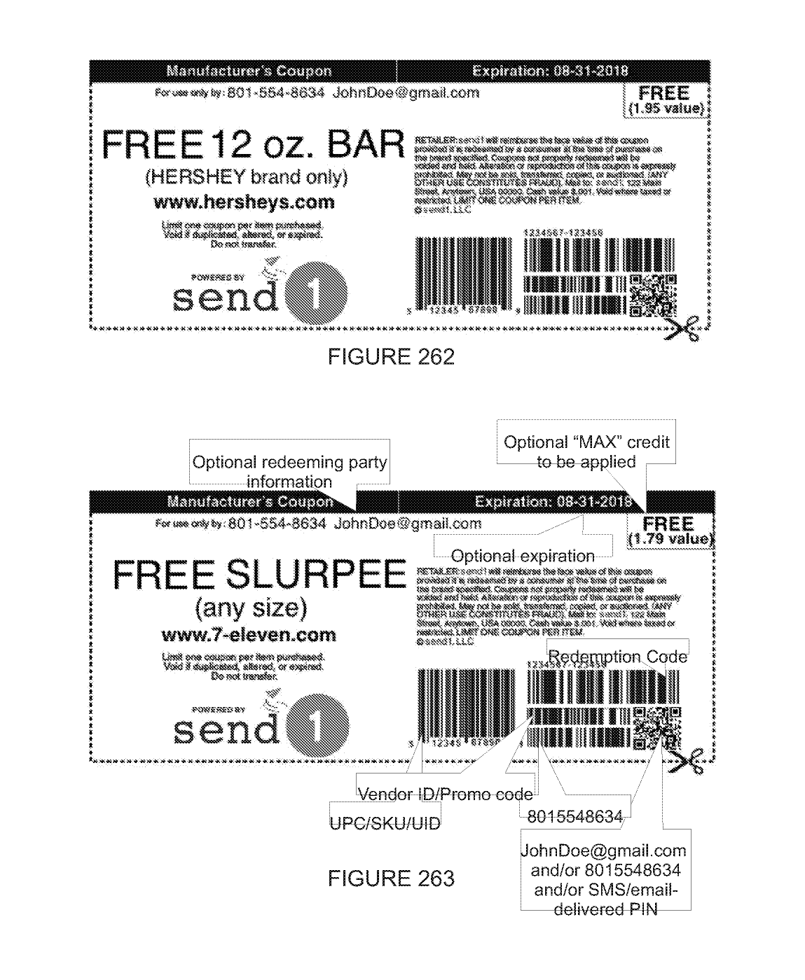

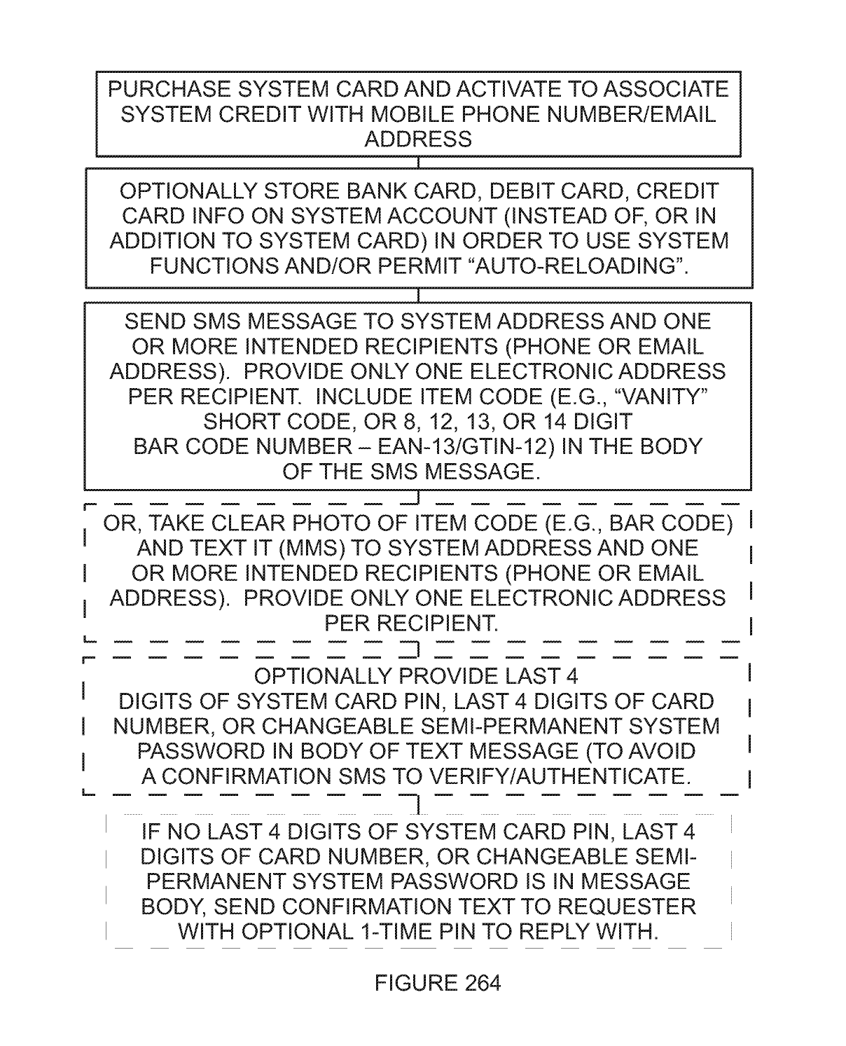

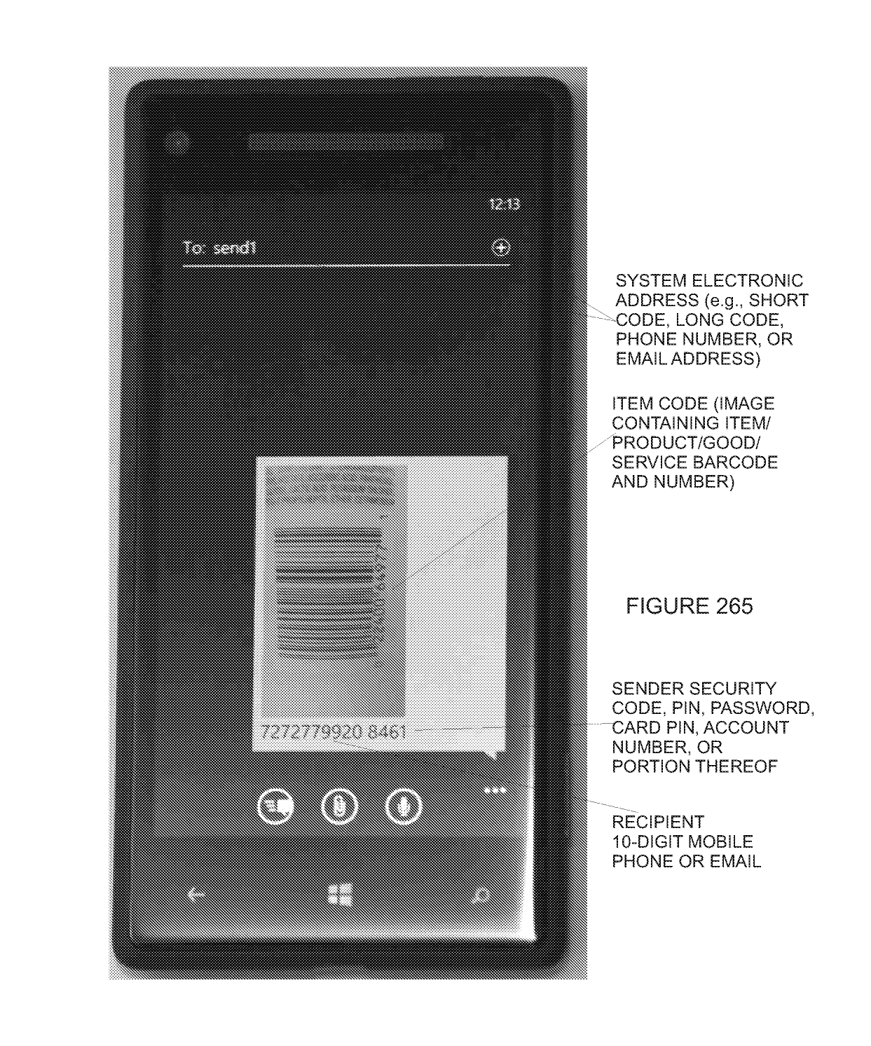

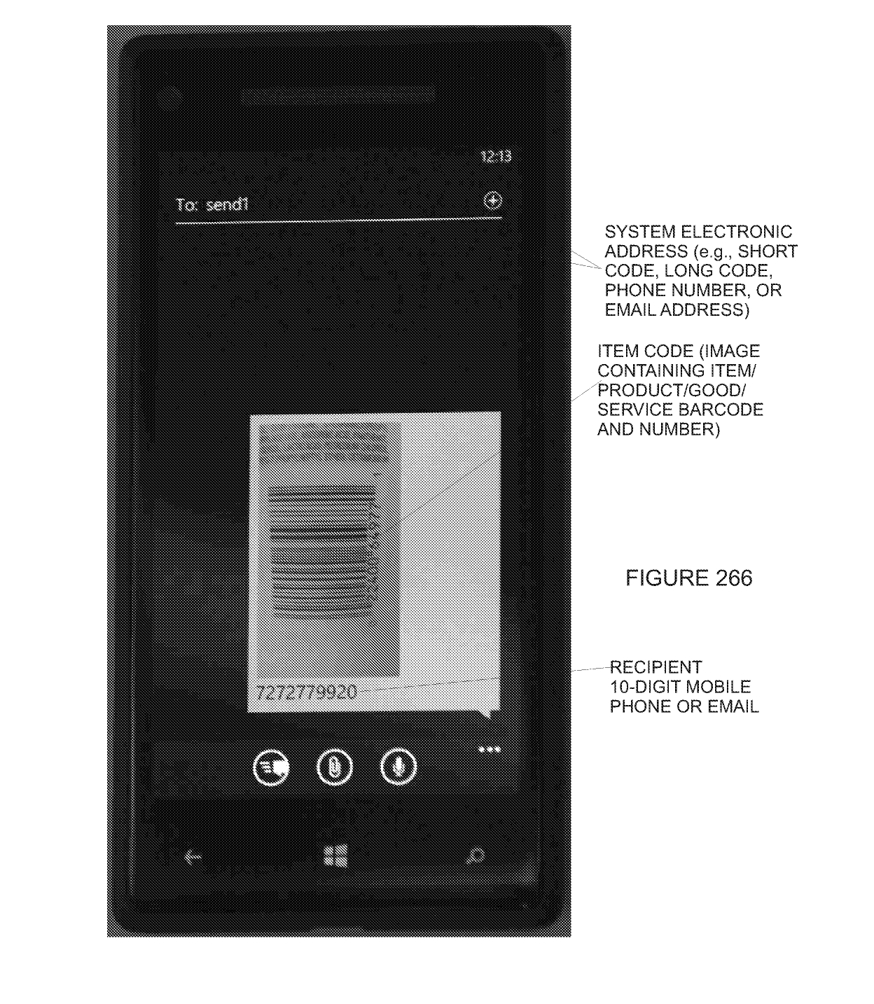

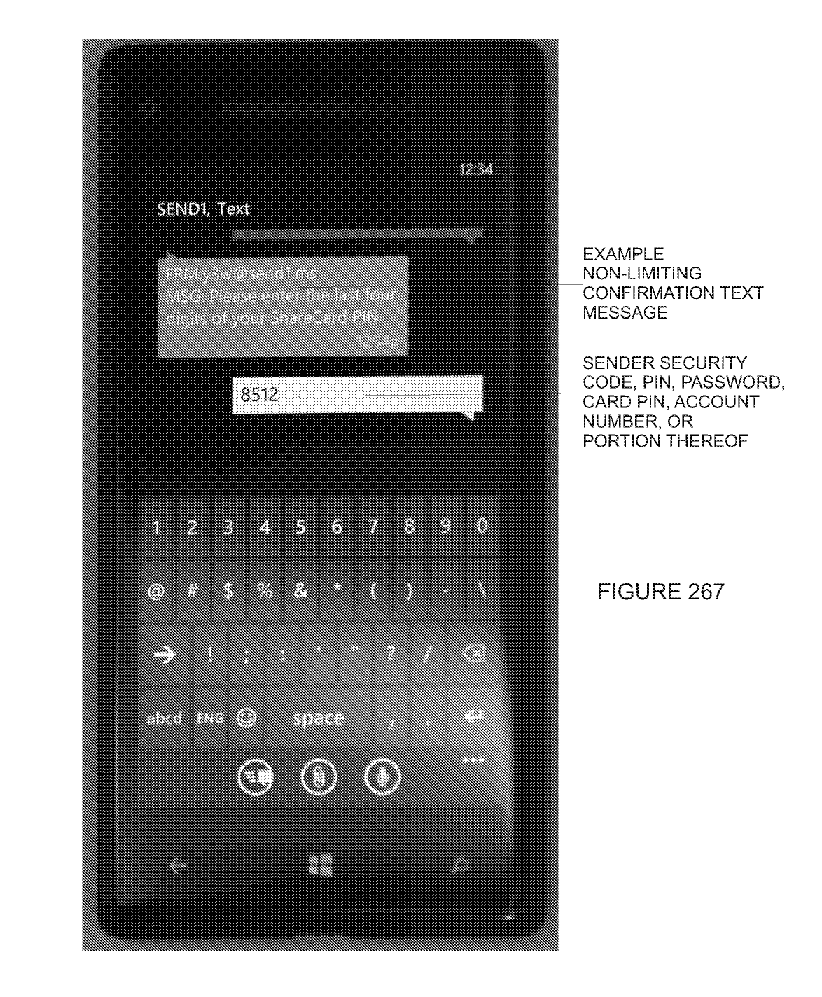

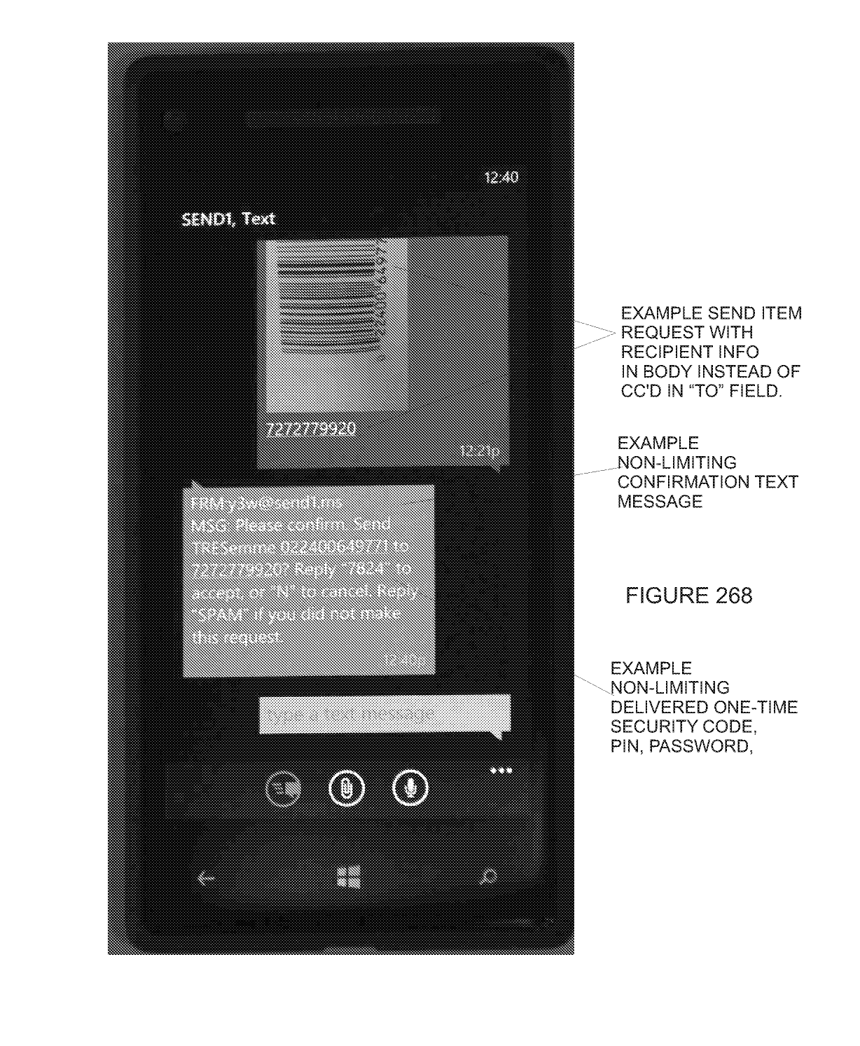

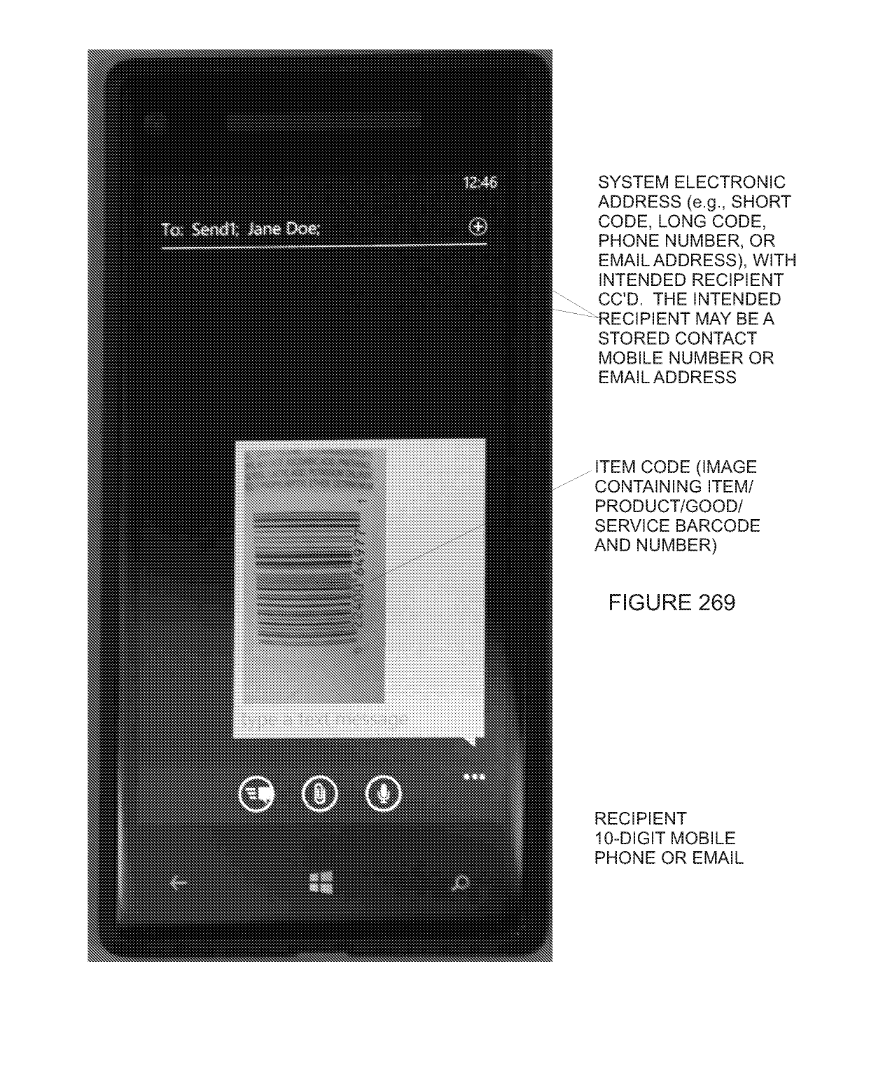

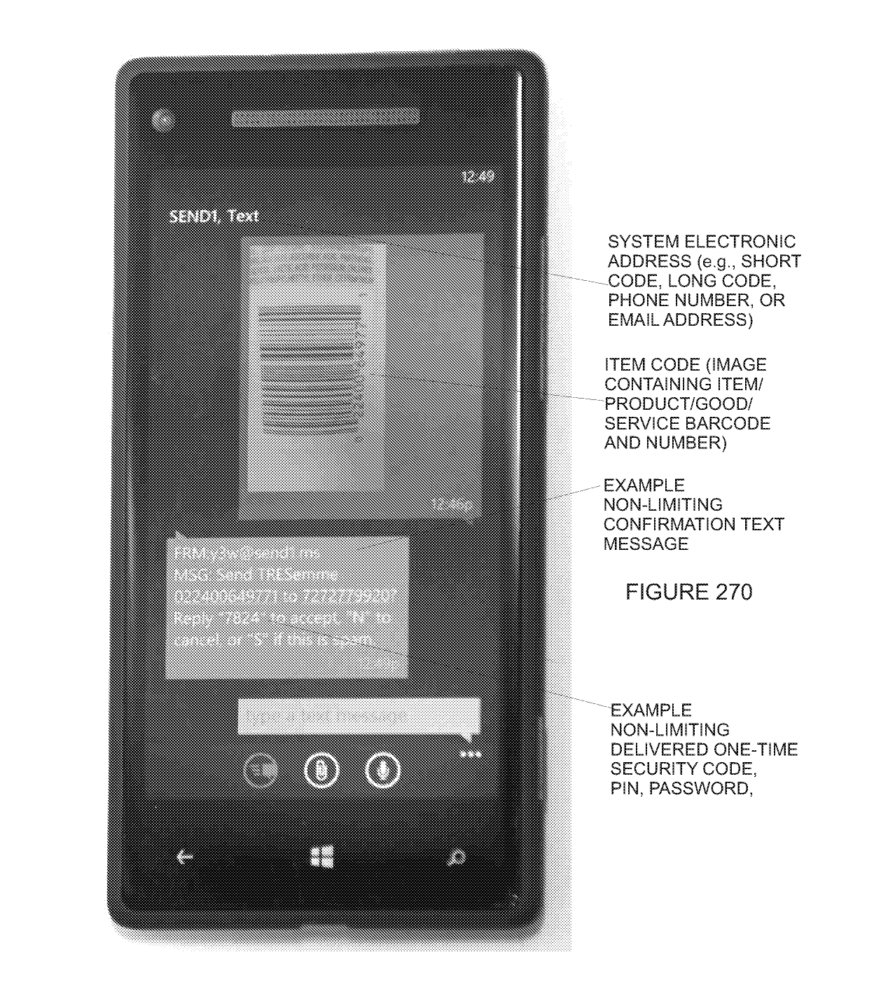

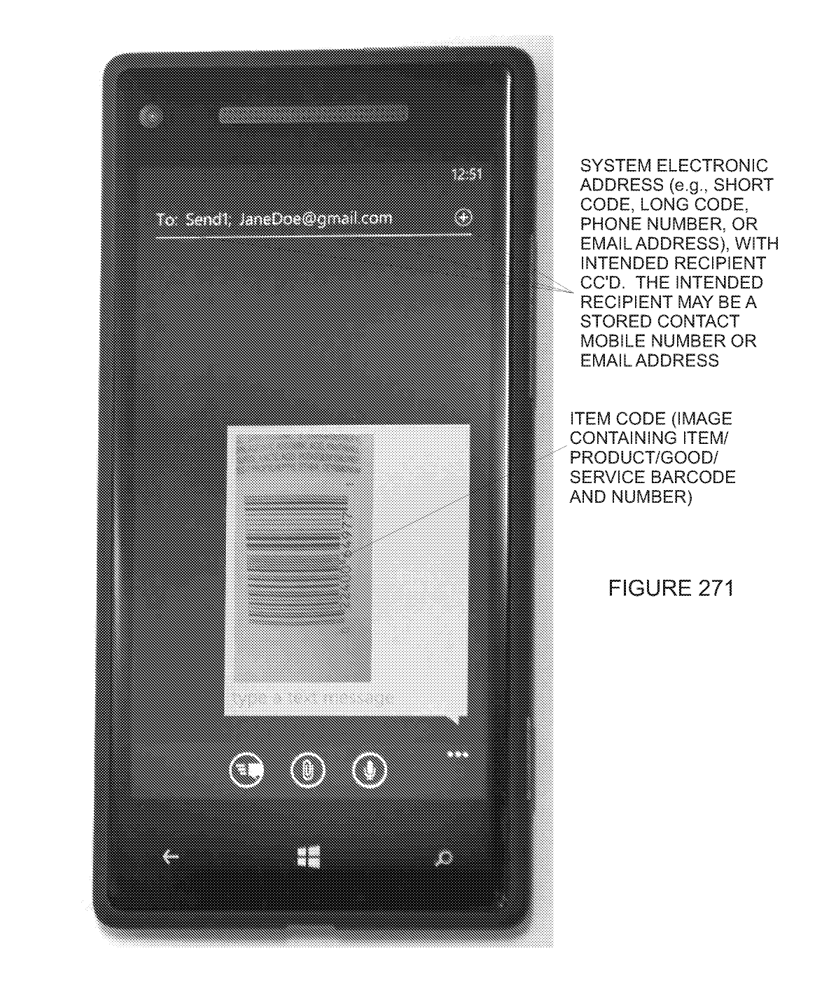

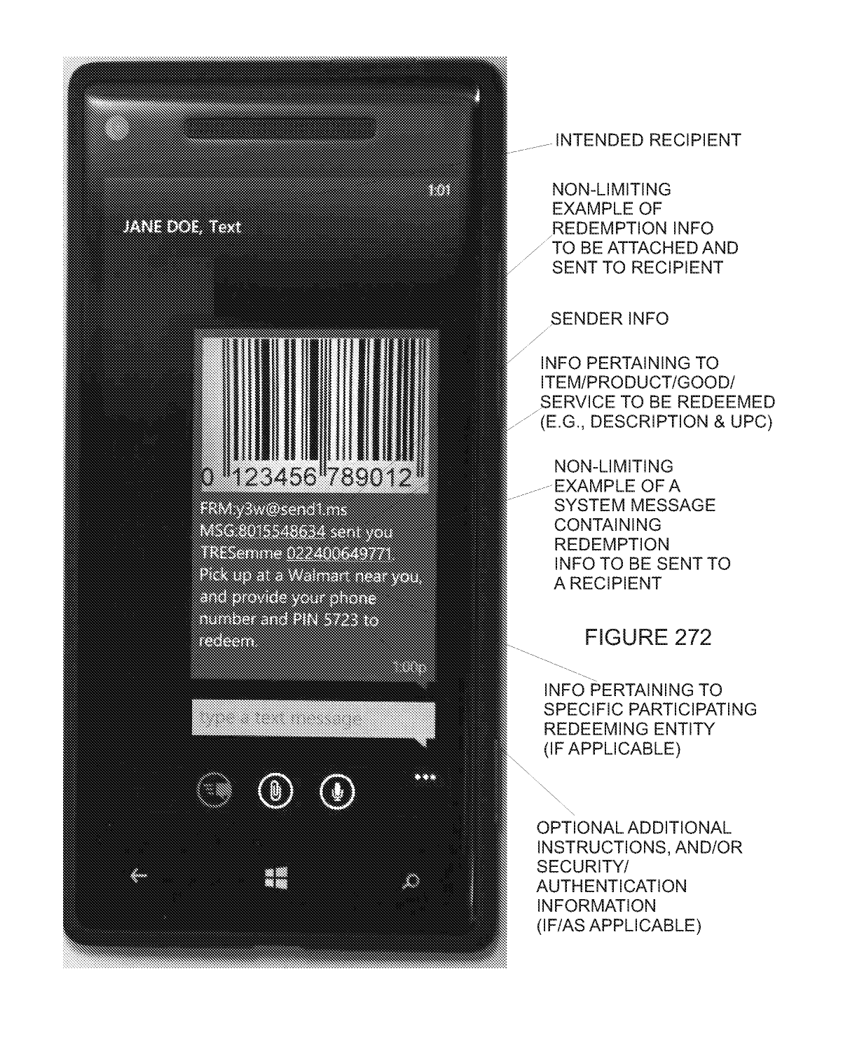

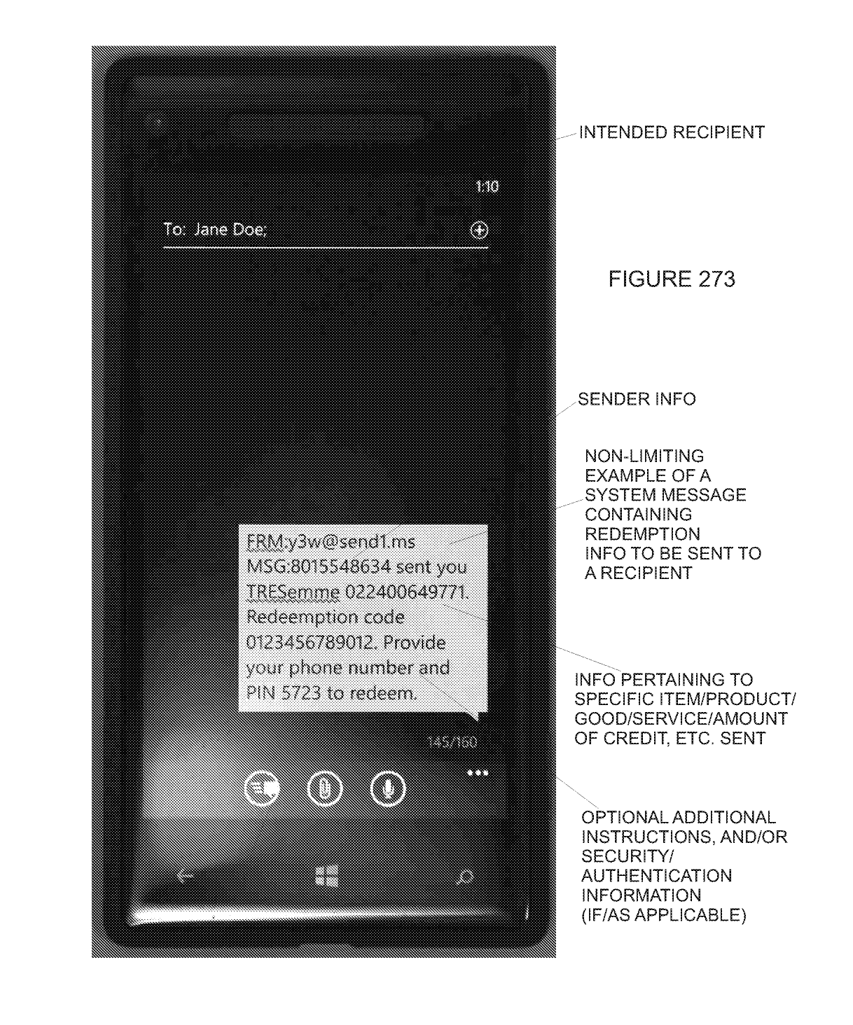

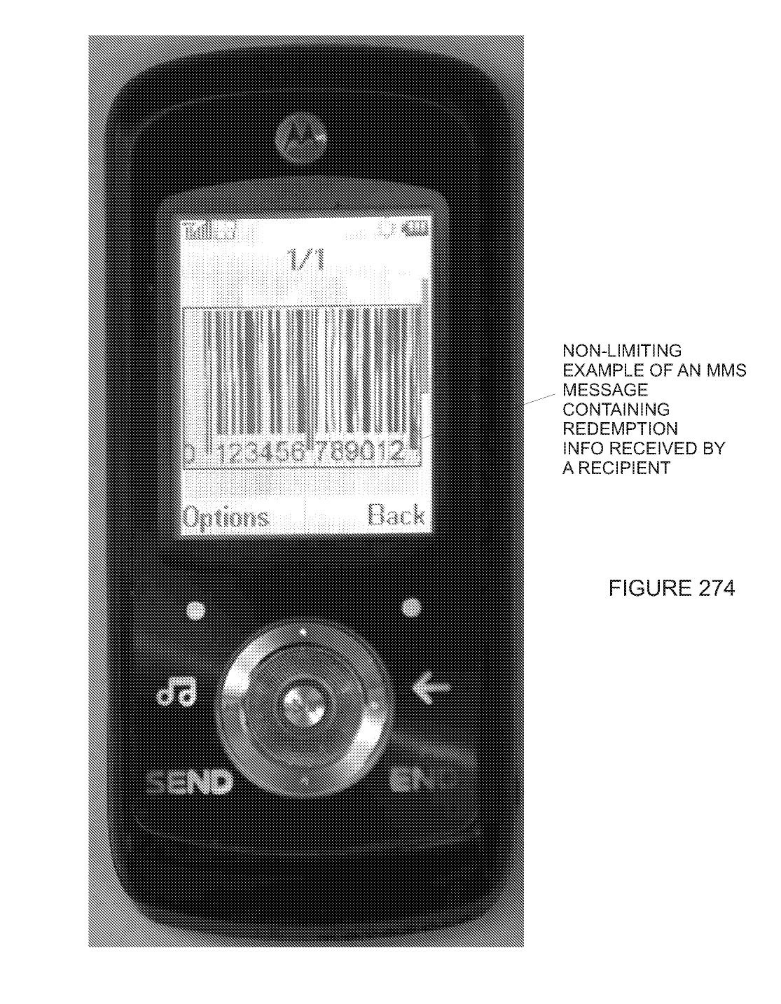

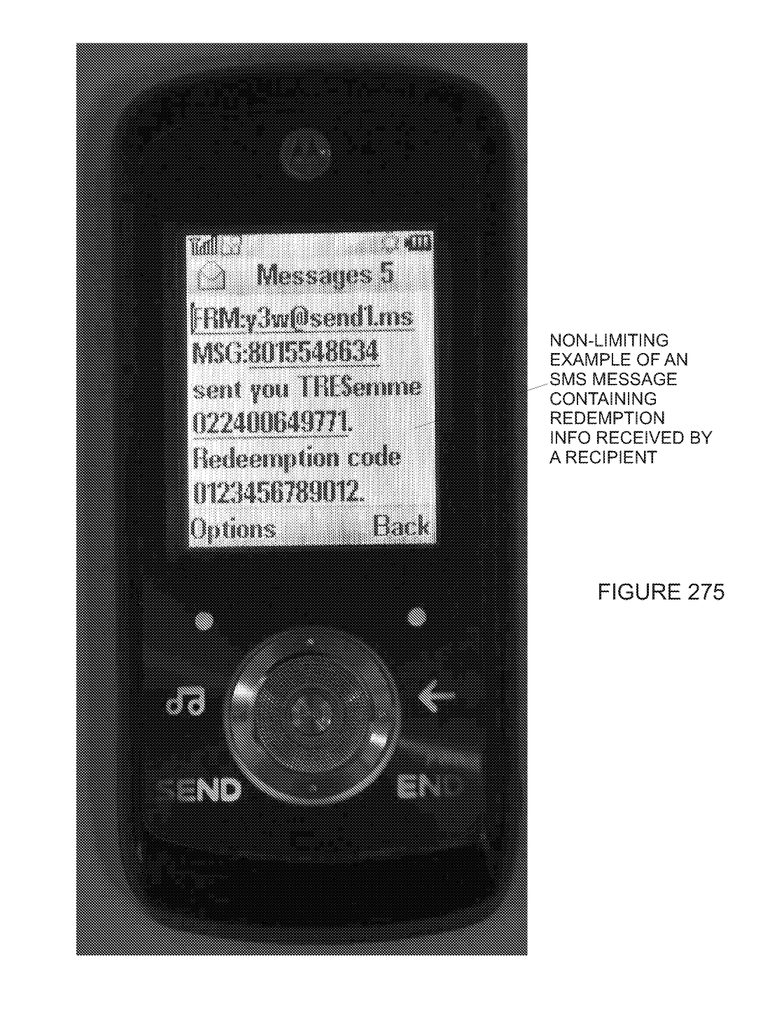

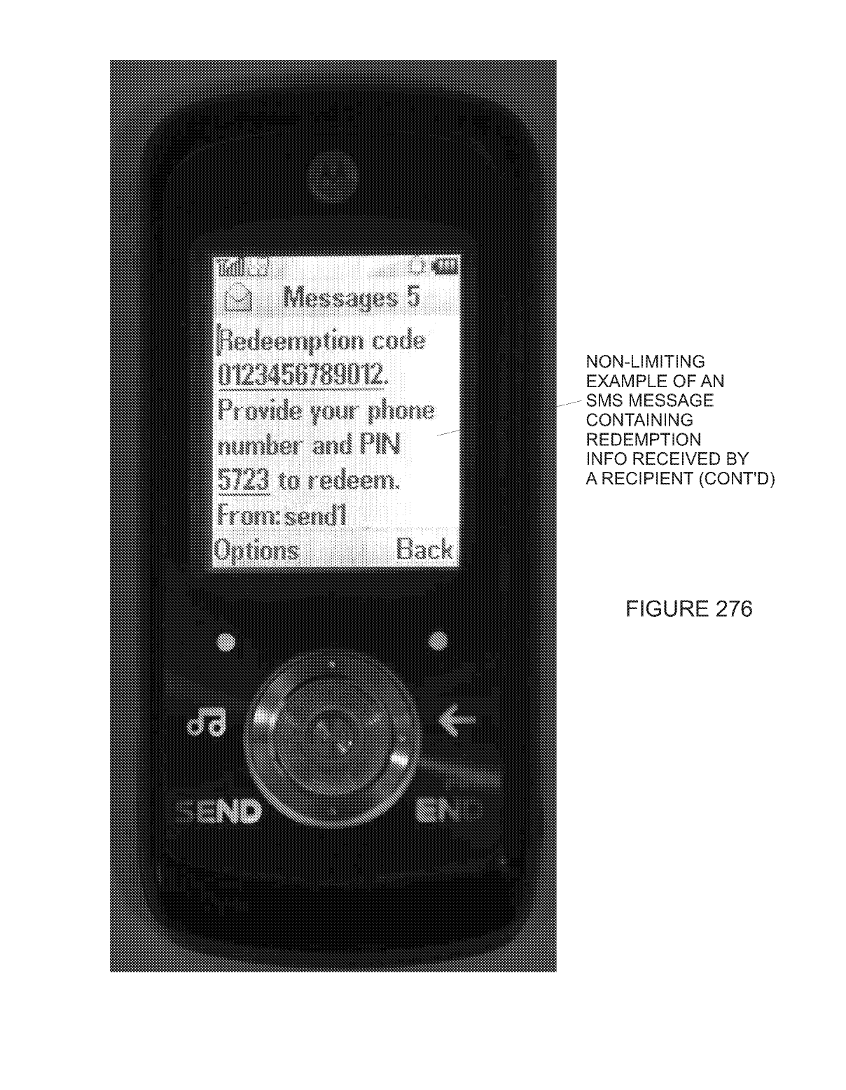

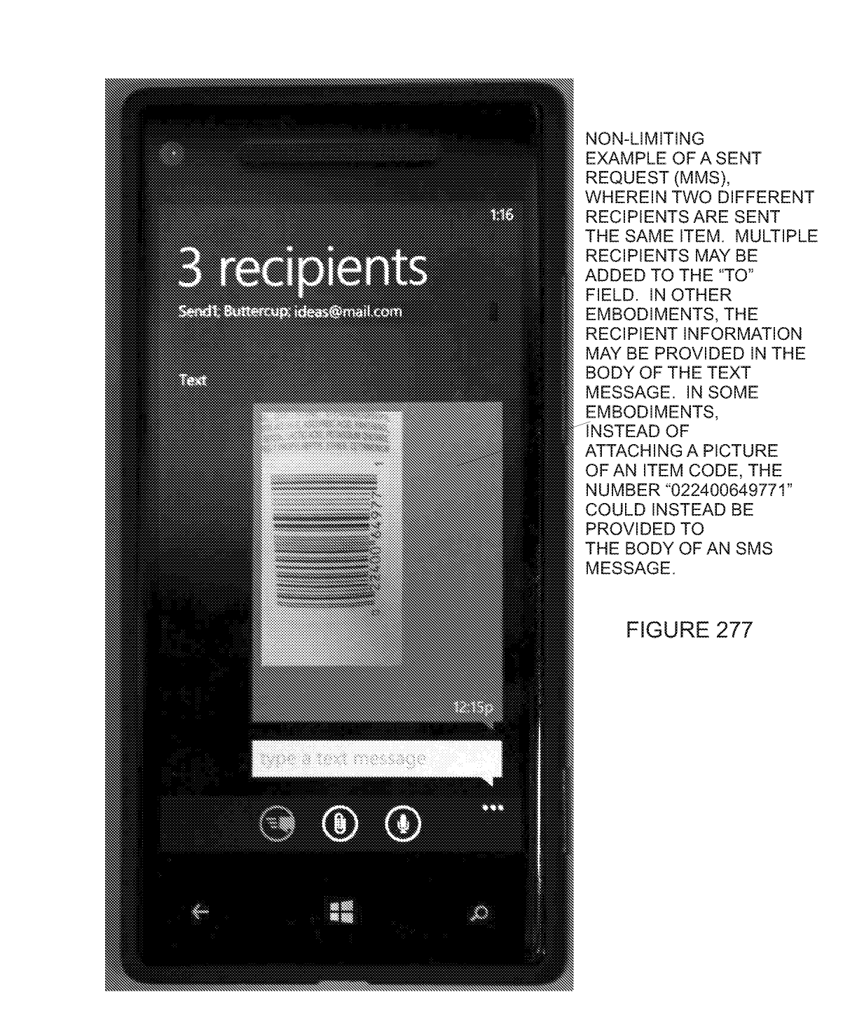

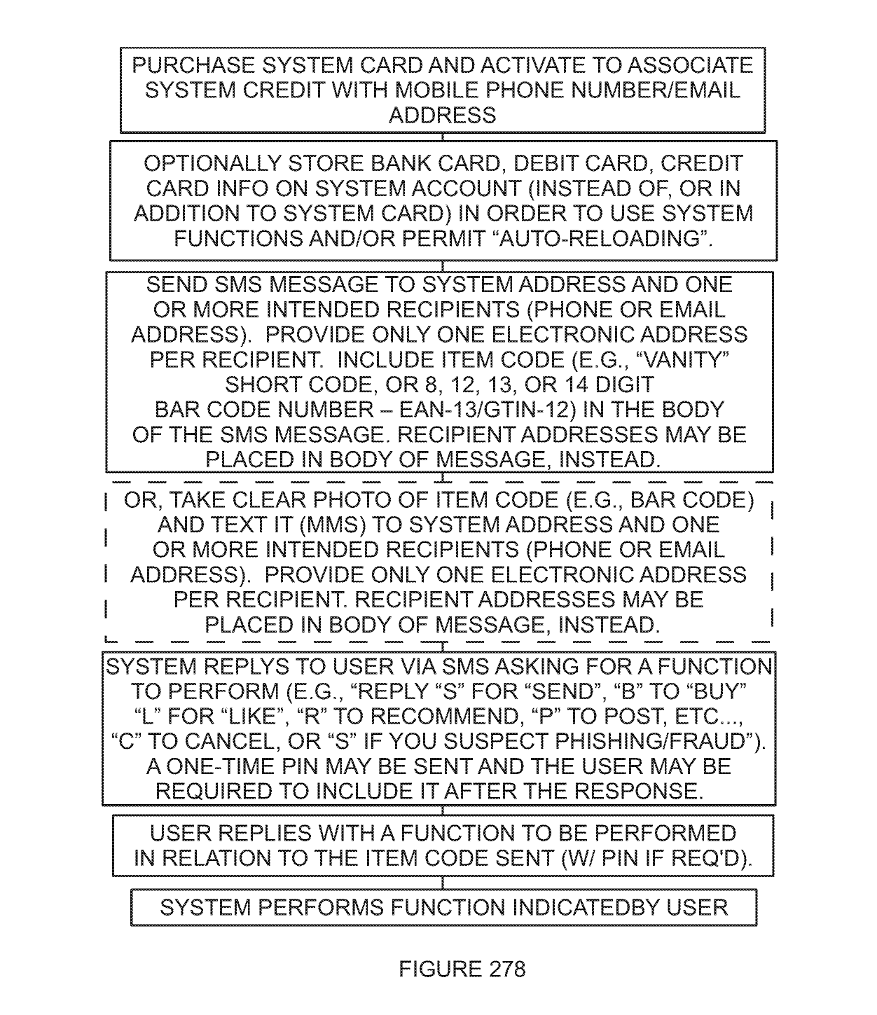

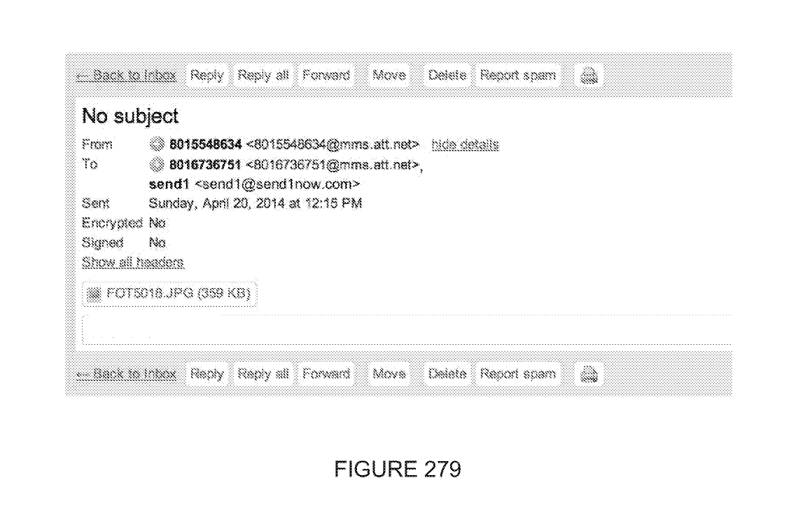

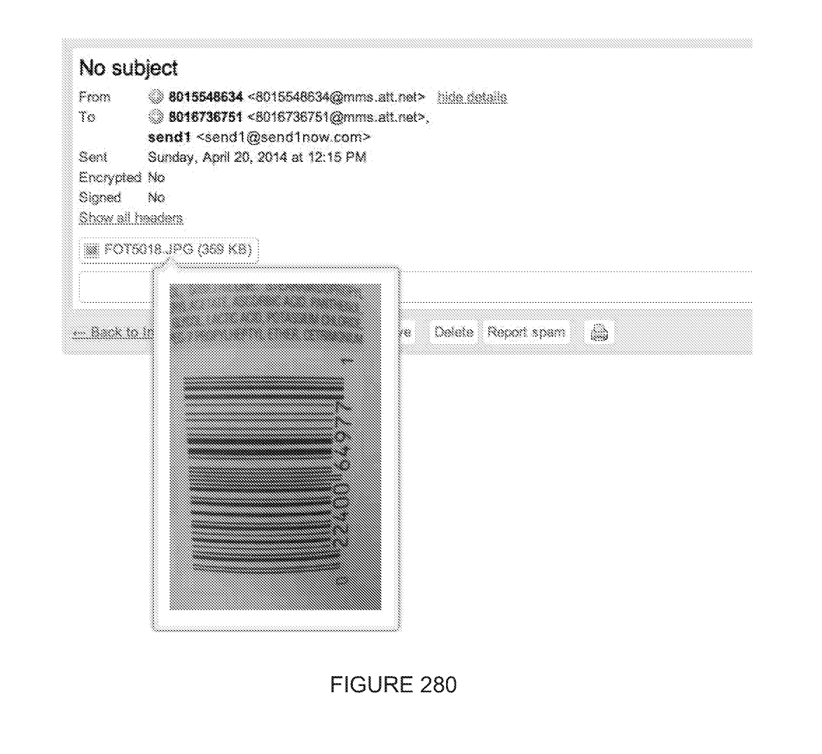

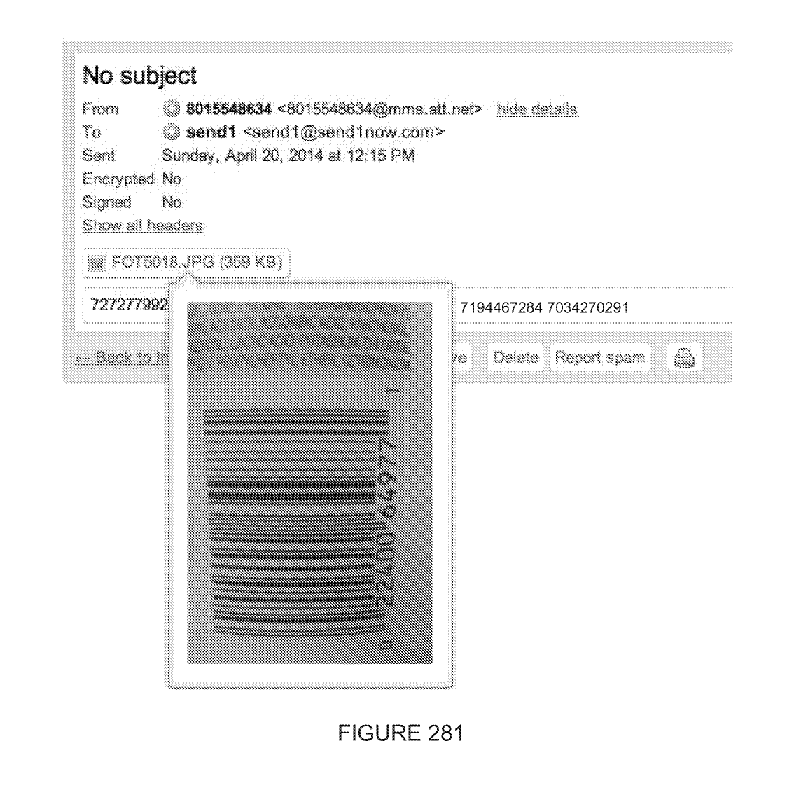

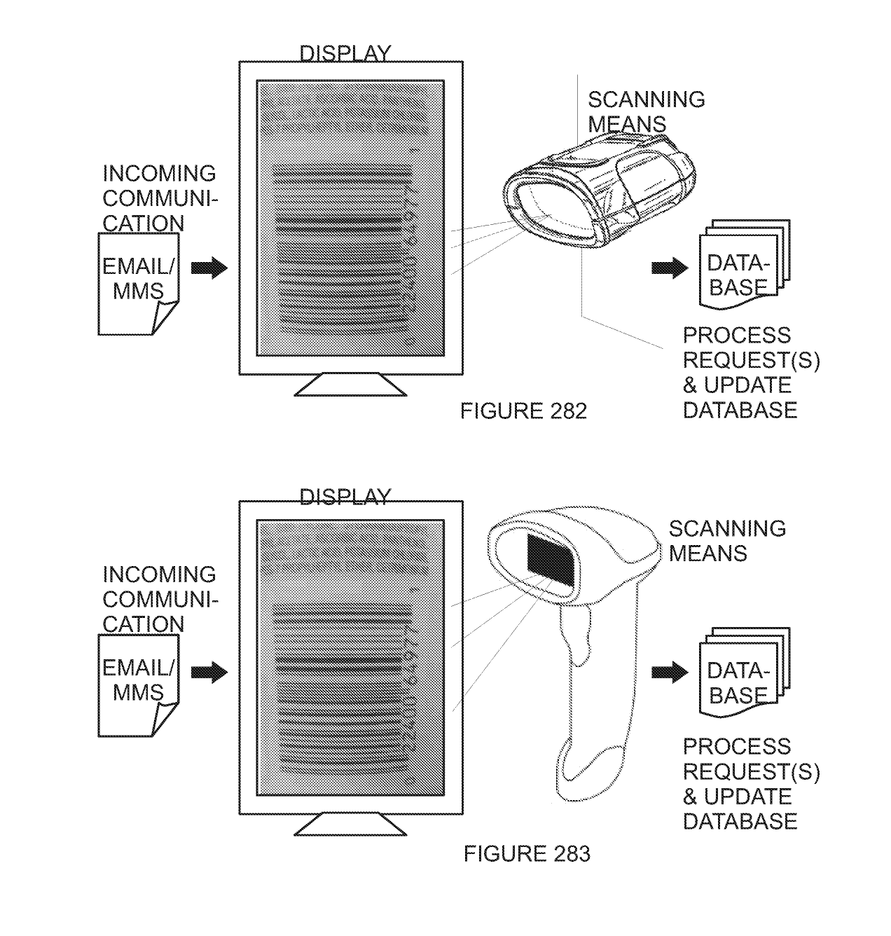

In some embodiments, one or more PINs may be encoded in a security barcode of delivered redemption information 64 (e.g., a security barcode which may comprise one or more printable and/or screen-displayable machine-readable images, without limitation). In some non-limiting embodiments, the redemption information 64 may be sent from the system, to a recipient, via email or text messaging. In some non-limiting embodiments, one or more user inputs 4, such as instructions for the system (e.g., regarding a transaction to be made or function to be performed), may be sent from a requesting user, to the system, via email or text messaging. In such non-limiting embodiments (as well as for embodiments employing other electronic communication protocols described herein, like social media 93 platform-based and/or web form submission-based protocols), upon use/redemption of the delivered redemption information 64, a redeeming entity 65 may scan the security barcode using a system component such as a payment terminal configured with reader means (which may, in turn, reveal the one or more PINs encoded in the security barcode to the redeeming entity 65, via a user interface 106 associated with the system component). The redeeming entity 65 may ask (e.g., via a store employee of the redeeming entity 65) the redeeming user presenting redemption information 64 for one or more PINs (e.g., one or more PINs which may have been delivered to the redeeming user's electronic address, such as a mobile phone number or email address of the redeeming user, upon redemption, or prior to redemption). If the one or more PINs encoded in the security barcode matches the one or more PINs delivered to the redeeming user (i.e., recipient/holder of the redemption information 64), received by the redeeming user, and/or provided by the redeeming user to the participating entity 65, the transaction may be completed (e.g., the participating entity 65 may exchange one or more items, products, goods, or services to the redeeming user in exchange for the redemption information 64). For example, as shown in FIGS. 262 and 263, redemption information 64 comprising a printable or mobile device screen-displayable coupon (e.g., delivered from the system to a recipient via email or SMS/MMS/mobile messaging, without limitation) may comprise, without limitation, a notice of whothe redemption information is for (i.e., user data 8 comprising recipient information such as one or more phone numbers or email addresses of one or more recipients). To ensure that the redemption information 64 is not altered in bad faith, the same information may be encoded in one or more security barcodes, such as one or more machine-generated/machine-readable images provided on the printable coupon/mobile device screen-displayable coupon, without limitation. Alternatively, in some embodiments, the printable coupon/mobile device screen-displayable coupon may comprise one or more PINs encoded in one or more security barcodes. The same one or more PINs may be electronically sent (e.g., via SMS, email, voicemail, mobile messaging, social media, etc., or the like) from the system, to the one or more recipients (e.g., a redeeming user/gift recipient having an electronic address of “801-554-8634” or “JohnDoe@gmail.com” as shown in FIGS. 262 and 263), prior to use/redemption of the redemption information 64, or in real-time during use/redemption of the redemption information 64, without limitation. If the encoded one or more PINs match the one or more PINs electronically sent, the redeeming entity 65 may complete the transaction and provide the one or more recipients of the redemption information 64 (e.g., the redeeming user/gift recipient having an electronic address of “801-554-8634” or “JohnDoe@gmail.com” shown in FIGS. 262 and 263) with the appropriate corresponding one or more items, products, goods, or services (e.g., a 12 oz. Hershey brand food product in the embodiment shown in FIG. 262, or a free 7-11 brand Slurpee brand beverage product in the embodiment shown in FIG. 263), without limitation. In some embodiments, the system may immediately deactivate the redemption information 64 associated with the one or more PINs, since the one or more recipients of the redemption information 64 (e.g., redeeming user/gift recipient having an electronic address of “801-554-8634” or “JohnDoe@gmail.com”) has effectively “used” or otherwise “redeemed” the redemption information 64. It should be understood that where used in the example above and/or throughout this disclosure, a “PIN′ or “PINs” may comprise one or more security codes, authentication codes, validation codes, store codes, types of security features, or the like, without limitation.

In some embodiments, a user may create one or more arbitrary one-time pass codes, PINs, or the like (e.g., “i56kg” or “lb3_j74”), and include it before or after or within syntax used to make a transaction request (whether it be purchasing redemption information 64, sending funds or credits, paying for one or more items, products, goods, or services, liking items, recommending items, etc., without limitation). Moreover, the one or more arbitrary one-time pass codes, PINs, or the like may be provided to a web page field of a system-integrated website or a website being accessed by a browser 131 having a system add-on or app 147 applied thereto (e.g., via download and setting to “enable” or “set to active”), without limitation. The one or more arbitrary one-time pass codes, PINs, or the like may be parsed from the incoming request by system components 128, 147, stored (e.g., temporarily in a system database 129), and a response communication may be sent back to the user (e.g., using the same platform, or a different platform). The response communication from the system may prompt the user to re-provide the same one or more arbitrary one-time pass codes, PINs, or the like in a reply response to the response communication sent by the system. The user may re-enter the response to the response communication in a reply response to be delivered to the system (e.g., to the electronic address from which the response communication was delivered). The user may send the reply response to the system, and, upon receipt of the reply response, the system may verify that the one or more arbitrary one-time pass codes, PINs, or the like match the one(s) stored (e.g., in the database 129). If the one or more stored arbitrary one-time pass codes, PINs, or the like match the one or more arbitrary one-time pass codes, PINs, or the like provided in the reply response, the preceding transaction request may be authenticated/validated, and processed by the system to completion, without limitation.

In some embodiments, redemption information 64 may contain one or more redemption instructions. In some embodiments, the instructions might require a user of the redemption information 64 to text a string of characters, numbers, and/or letters (e.g., a redemption code and/or vendor ID, without limitation) to a certain electronic address upon/during use/redemption of the redemption information 64, or just prior to use/redemption of the redemption information 64, without limitation. The system may, in some embodiments, reply to such a communication with a reply communication to the user of the redemption information 64, wherein the reply communication may contain one or more redemption PINs (which may be provided to the redeeming entity 65 who intends to accept the redemption information 64). In some embodiments, the user of the redemption information 64 may provide the one or more redemption PINs to a redeeming entity 65 during use/redemption of the redemption information 64, and, upon receipt of one or more redemption PINs from user of the redemption information 64, the redeeming entity 65 may record the one or more redemption PINs for its own records. The recorded one or more redemption PINs may be provided to one or more receipts 20 relating to the transaction, which may be given to the user of the redemption information 64, and/or the recorded one or more redemption PINs may be used by the redeeming entity 65 to validate the transaction and/or to use in a claim made to the system for reimbursement. According to some embodiments, software 147 associated with payment receiving means 100 (e.g., a P-O-S payment terminal) of the redeeming entity 65 may populate information into its own database(s) 137, the information which may include the redemption information 64—including the one or more redemption PINs, without limitation. These and other numerous security measures which may be designed to prevent misuse of system components and/or fraudulent uses of the system may be employed, without limitation.

According to some non-limiting embodiments, redemption information 64 provided to a redeeming user 92 (e.g., a recipient of redemption information 64) may comprise one or more security barcodes (e.g., a QR code or other machine readable indicia). In some embodiments, the one or more security barcodes may comprise one or more embedded PINs or security information. In some embodiments, the one or more security barcodes may comprise information pertaining to a status (e.g., used/unused status) of redemption information (e.g., a redemption code). In some embodiments, the one or more security barcodes may comprise information pertaining to proper redeeming user information (e.g., electronic address information pertaining to one or more appropriate or “bona-fide” recipients of redemption information 64). For example, in some embodiments, when scanned by a payment terminal barcode scanner (e.g., a QR code reader), system mobile application 147 installed on a mobile device 96 or computing device 95, or the like, the one or more security barcodes may display to a redeeming entity 65 (or user 91, 92 accepting the redemption information 64 as a form of payment), via display means or user interface 106, a string of characters (e.g., “527U82KSTL1732KN28014”), wherein a portion of the string, (e.g., the four characters “KN28” which precede the last three characters of the string) may represent one or more PINs or security information which: may have been pre-delivered to the redeeming user's electronic address(es) and accessed by the redeeming user's mobile device 96; may have been delivered to the redeeming user's electronic address(es) and accessed by the redeeming user's mobile device 96 upon redemption/scanning; and/or may have been delivered to the redeeming user's electronic address(es) and accessed by the redeeming user's mobile device 96 upon the redeeming user 92 following instructions and sending a “redeem” electronic request communication (e.g., via email, SMS, MMS, mobile application instruction, web submission, social media post, or the like) to the system in accordance with the instructions, without limitation.

Alternatively, or in addition to this, in some non-limiting embodiments, the string of characters may contain identifying information about the proper recipient of the redemption information 64 and/or user data 8 pertaining to the redeeming user(s) 91, 92. For example, just as QR codes commonly contain a website URL, redemption information 64 and/or user data 8 pertaining to the redeeming user(s) (e.g., coupon code, recipient electronic address information, etc.) may be contained within the string of characters. In this regard, in some embodiments, a separate PIN delivery from the system to a redeeming user(s) may not be necessary. For example, when scanned by a payment terminal barcode scanner 95 (e.g., a barcode scanner, QR code reader) or a mobile device 96 adequately configured with a system mobile application 147, information coded within the one or more security barcodes may be received, processed, and displayed to a redeeming entity 65 via system components, for example, as a string of numerical information (e.g., “819374618015548634162883”), wherein a portion of the string, (e.g., wherein the 10 integers “8015548634” preceding the last five characters may contain the bona-fide recipient's/redeeming user's phone number. It is envisaged that where used herein, a “string” may be parsed by system-integrated software 147 and the parsed data may be displayed in a more user-friendly or intuitive format via a user interface 106 (e.g., “Valid for: user 8015548634”, without limitation). It is also envisaged that multiple recipient information may be contained within a “string” (e.g., “819374618015548634162703402981183”), without limitation. In some non-limiting embodiments, the redeeming entity 65 may ask for a redeeming user's electronic address (e.g., phone number or social media screen name), and if the provided redeeming user's electronic address information (e.g., phone number or social media screen name information) doesn't match the bona-fide recipient's/redeeming user's electronic address, the redeeming entity 65 may opt to decline the transaction at its own discretion. It should be noted that in some non-limiting embodiments, the bona-fide recipient's/redeeming user's electronic address information may be coded, scrambled, or otherwise encrypted within the string according to an algorithm, and may be decoded, unscrambled, or otherwise decrypted according to an algorithm (e.g., an encryption/decryption algorithm), without limitation.

As yet another non-limiting example, one or more security barcodes may be utilized to display to a redeeming entity 65 a string, or a portion thereof, containing character information (e.g., “9H2$SV̂TXJOHNDOE@GMAIL62TXEYW%”), wherein a portion of the string, (e.g., a middle, beginning, or end portion of the string) may contain information pertaining to a bona-fide recipient's/redeeming user's 92 email address, without limitation. It should be understood that in some embodiments, one or more other types of electronic addresses may be provided within a string (e.g., “9H2$SV̂TX@JOHNDOE62TXEY7034029811W%”), without limitation. It should be understood that in some embodiments, multiple bona-fide recipient/redeeming user email addresses may be provided within the same string (e.g., “9H2$SV̂TXJOHNDOE@GMAIL62TXEYJANEDOE@YAHOOW%”), without limitation. System software 147 provided to the payment terminal 95, or a mobile application 147 downloadable to the redeeming entity's mobile device 96 may automatically decipher and extract the relevant information according to its own system-proprietary algorithms and may display the relevant information to the redeeming entity in a GUI user-friendly manner, without limitation. The redeeming entity 65 may, in some embodiments, ask the redeeming user 92 for the redeeming user's email address (and/or other electronic address(es)), and if the provided redeeming user's email address (and/or other electronic address(es)) doesn't match the information embedded in the one or more security barcodes (e.g., “string”), then the redeeming entity 65 may opt to decline the transaction at its own discretion. As previously stated, it should be noted that the bona-fide recipient's/redeeming user's email address may be coded, scrambled, or otherwise encrypted within the string according to an algorithm, and may be decoded, unscrambled, or otherwise decrypted according to an algorithm (e.g., an encryption/decryption algorithm), without limitation.

As yet another non-limiting example, one or more security barcodes may, in some embodiments, be encrypted and/or decrypted according to system-proprietary algorithms. For example, in some embodiments, a proprietary algorithm may be used to decrypt redeeming user information 8 which has been decoded from one or more security barcodes. For example, a security barcode (1D or 2D) relating to redemption information 64 provided to a redeeming entity 65 by a user 91, 92 may comprise encrypted embedded electronic address information of the user 91, 92 (e.g., an encrypted embedded phone number or email address information). For example, if a redeeming user's 92 electronic address is “8015548634”, a decoded security barcode may comprise an encrypted string, for example, “102382473856578724”, which, when decrypted by system-proprietary software 147, may provide the redeeming entity with “8015548634”; for example, by, in sequence, listing the fifteenth digit first, the second digit second, the first digit third, the thirteenth digit fourth, the eleventh digit fifth, the eighteenth digit sixth, the fifth digit seventh, the twelfth digit eighth, the ninth digit ninth, and the seventh digit tenth, according to a system-proprietary algorithm. The exact description algorithm used in the system software 147 may be maintained in confidence by secure system personnel having access to the software 147 via the system server 128, without limitation. According to some embodiments, the algorithm may change periodically, without limitation; wherein issue date 69 information associated with the redemption data 64 may be utilized to determine which algorithm is to be used to perform the decryption of the decoded string(s), without limitation. In some embodiments, the redeeming entity may, after decryption, ask for the redeeming user's 92 electronic address (e.g., phone number), as a security token/key to validate the redemption information without necessarily needing to independently communicate with the system to authorize the transaction. In this regard, mass distribution of pre-paid redemptions or fraud (e.g., by scanning or doctoring redemption information) may be reduced and/or avoided. In some non-limiting embodiments, information in one or more first security barcodes may be utilized as an encryption key or token for one or more other second security barcodes provided with redemption information, without limitation. Various permutations and combinations of the security features 60 provided as user inputs 4 to system components 3, 95, 96 described herein are envisaged, without limitation.

In the event redeeming user information 8 is encoded in machine-readable indicia, the system may use its own proprietary encryption/description algorithms and/or proprietary machine-generated/machine-readable indicia to prevent or discourage deciphering by the public and/or tampering with system components in an effort to deceive the system and/or its client users or customers 65, 91, 92, 163, 93, 94.

For example, redeeming entities 65 may, in some embodiments, download a system application 147 on a separate mobile device 96 or payment terminal 3, 95, 100. Upon use/redemption of redemption information 64, a redeeming entity 65 may enter the redemption information 64 (e.g., one or more redemption codes) into the system application 147 interface 106 or payment terminal 3, 95,100 installed with system software 147. The system may send both the redeeming entity 65 and the redeeming user 92 a one-time use PIN upon use/redemption of redemption information 64 (e.g., via SMS for the redeeming user, and via the system application 147 or payment terminal software and network 118 communicating with a system-integrated server 128 for the redeeming entity 65), without limitation. It is envisaged that rather than SMS protocols, the system may send the redeeming user 92 a one-time use PIN using another electronic communications protocol shown or described herein (e.g., via a mobile application, MMS, email, social post, voicemail, voice call, video chat, and/or the like), without limitation. It is also envisaged that the system may send the redeeming entity 65 a one-time use PIN using electronic communications protocols shown or described herein (e.g., via a mobile application, MMS, email, social post, voicemail, voice call, video chat, and/or the like), without limitation.

Alternatively, in some embodiments, a redeeming entity 65 may, one or more similar manners, receive from the system (e.g., via the system application or payment terminal), a redeeming user's electronic address information (e.g., a redeeming user's 10 digit mobile phone number. The redeeming user 91, 92 may, upon use/redemption of redemption information 64, provide one or more of their electronic addresses (e.g., their 10 digit mobile phone number) to a redeeming entity 65 (e.g., as a PIN or in lieu of a PIN), in order for the redeeming entity 65 to confirm identity of the redeeming user and ensure that the redemption information 64 (e.g., a redemption code) is being properly used and stays with the appropriate (i.e., “bona-fide”) recipient of pre-purchased redemption information 64.

Alternatively, each redeeming entity 65 may create one or more vendor-specific pass-codes, and provide them to the system (e.g., via a system website 127 portal, via access to the redeeming entity's profile 130, physically, via mail, via file upload to the system website 127, via system software 147 provided to the redeeming entity's computing device 95 having connection means to the system server 128 through a network 118, via entering into a user interface 106 provided to the redeeming entity's 65 payment terminal 100, and/or via another electronic communication method disclosed herein, without limitation). Upon use/redemption of redemption information 64, the redeeming entity 65 may provide redemption information 64 to a system user interface 106 (e.g., type in a redemption code to a payment terminal 100), which may trigger, via system software 147 (e.g., server-side scripts), the system to send a one-time SMS pass code to the redeeming user 92 presenting the redemption information 64 (e.g., a redemption code) wherein the one-time SMS pass code sent to the redeeming user 91 may be selected from the one or more vendor-specific pass-codes provided to the system. In this regard, the redeeming user 92 may provide the received one-time SMS pass code to the redeeming entity 65, so that the redeeming entity 65 can verify whether or not the provided one-time SMS pass code matches any one or more of the one or more vendor-specific pass-codes. According to some preferred embodiments, the redeeming entity 65 may periodically change the one or more vendor-specific pass-codes to reduce the chance of possible fraud; for example, changes to the one or more vendor-specific pass-codes may be made periodically, at predetermined time intervals (e.g., once a month, once a week, once a day, once an hour, once every half hour, once every minute, etc), without limitation. The list of vendor-specific pass-codes may, in some instances, be printed out and may be kept near the P-O-S terminal or in a drawer thereof, or other safe place out of view of customers. In some embodiments, a single vendor-specific pass code may be used. In some embodiments, a single system-wide pass code may be used for all system transactions made by all participating entities 65 and users 91, 92. In some embodiments, similar procedures may be performed, where instead of a list of vendor-specific pass codes, a list of system-wide pass codes may be employed and/or utilized in a similar manner.

Alternatively, in some embodiments, upon use/redemption of redemption information 64 such as a redemption code, the system may send a “vendor-recognized” code, promo code, coupon code, pass code, or barcode (e.g., via MMS) to the redeeming user 92. In other words, the redemption code may essentially comprise a placeholder or “pointer” in the system database 129 and may be without actual merchantable value to a vendor, wherein the redemption code may be associated with a real “vendor-recognized” code that has true merchantable vendor value; wherein the “vendor-recognized” code may be transmitted to a redeeming user's mobile device 96, displayed (e.g., via a system mobile application 147) on a redeeming user's mobile device 96, or otherwise provided to a redeeming user 92 via their mobile device 96, without limitation. In some embodiments, the redeeming user 92 may receive from the system (e.g., upon checkout during the transaction), vendor-recognizable prepaid voucher information associated with the redemption information 64 (e.g., one or more “vendor-recognized” codes), which may then be used, for example, internally, by the redeeming entity 65, to process the transaction. In some embodiments, following a transaction with a redeeming user 92, the redeeming entity 65 may make a claim to their corporate headquarters, to the manufacturer of the redeemed item(s), product(s), good(s), and/or service(s), and/or to the system for reimbursing, without limitation.

In some embodiments, users 91, 92 may ask a P-O-S checkout employee or store manager if they have any unused system redemption information 64 (e.g., unused “redemption credit”). For example, a checkout employee and/or his/her store manager may ask a user 92 for his/her electronic address(es), such as the user's 92 phone number (e.g., “8017462819”), and may then send an electronic inquiry to the system (e.g., via SMS, email, system application, payment terminal, etc.). In some cases, where the electronic inquiry is not performed using a system interface 106 with system software 147, the electronic inquiry may comprise an electronic message communication to a system electronic address (e.g., to a system-recognized vendor address “vendor172947827@send1now.com”) which may include the requesting user's provided electronic address(es) (e.g., the user's phone number). The system may then send an electronic message to any combination of the checkout employee, store manager, and/or the requesting user, notifying them if they have any have any unused system redemption information 64 (e.g., the system-delivered electronic message may comprise, for instance, a message indicating “user 8017462819 does not have any redemptions for vendor 172947827”, without limitation). In instances where unused system redemption information 64 is available, the system may provide a message comprising a listing all unused redemption information 64. In some preferred embodiments, where redemption information 64 pertains to specific participating entities 65, only relevant redemption information 64 may be provided. In this regard, a first participating entity 65 may only be provided with a user's unused redemption information 64 which relates to the first participating entity 65, and a second participating entity 65 may only be provided with a user's unused redemption information 64 which relates to the second participating entity 65, without limitation.

In some embodiments, a facility or brick and mortar location 2 of a participating entity 65 may display a system-recognized vendor ID and a user 91, 92 may send a secure communication to the system via an electronic message or mobile application 147 inquiring whether or not any unused redemption codes (i.e., redemption information 64) affiliated with their electronic address (e.g., phone number or email address) is redeemable at the respective vendor ID. This may involve providing at least the vendor ID, and a keyword command in an electronic message made to a system electronic address. In some embodiments, this may involve providing at least the vendor ID as an input to (e.g., to a user input 4 field by manually entering text into the field, or automatically using speech-to-text software) a user interface 106 of a system mobile application 147 on a mobile device 96, and selecting an icon or verbally providing a keyword command to the interface 106. Other forms and or combinations of forms of instructions are envisaged (e.g., including gesture or certain movements of the mobile device 96). Once a user's request is received by a system component, the system may, via a respective system component, send or otherwise provide, display, and/or emit (e.g., audibly), a listing or shorthand notation of the items/products/goods/services which may be able to be exchanged for unused redemption codes, by the respective entity 65 pertaining to the inputted vendor ID, without limitation.

According to some non-limiting embodiments, an exemplary mail.php script file may be created to parse emails and insert them into a system-integrated database (e.g., a MySQL database), for example, in real time as they are received by system components 3, 95, 96, 100. In some non-limiting embodiments, a solution may utilize Linux, (e.g., Ubuntu) with a mail server (e.g., an open source mail server such as Postfix), without limitation. The mail script may, in some embodiments, be based off of, may incorporate portions of, and/or may utilize parts of existing mail parsing scripts, for example, to eliminate “heavy lifting”, wherein code may be used to insert input 4 information into a database 129, 136, 137, 138 (e.g., a MySQL table, for example, using PDO, without limitation), may be used to manipulate database information, and/or may be used to extract database information and place it in an outgoing electronic communication, such as an electronic message. To start, a Linux server may be provided, without limitation. Amazon EC2 instances in the cloud may be utilized to do this via an AMI, without limitation. According to some embodiments, security preferences may be set to allow incoming on port 25 (SMTP). If there are any issues hindering operation and/or functionality, security/firewall settings may be adjusted, without limitation. For testing purposes, an inexpensive micro AMI may be used, without limitation. Once having SSH-ed into the box, a few commands may be run to make sure everything is up to date and that all the tools and/or software needed is installed. According to some embodiments, Apache may not be necessarily needed, but an entire lamp stack may be installed for ease and simplicity or for later use. In some embodiments, a system-integrated database 129, 136, 137, 138 may, for hypothetical purposes, may be called “email” and the mail table where incoming email may be stored may be call “mail”, without limitation.

According to some embodiments, the following non-limiting and non-exhaustive steps may be performed by the system, without limitation, wherein incoming electronic messages or electronic communications to the system (e.g., via SMS, MMS, or email, without limitation) may be interpreted by the system; for example, to facilitate the completion of a transaction comprising any one or more of: a transfer of funds and/or credit(s) between a first user and one or more second users; a purchase of one or more items, products, goods, or services by a first user for the first user and/or one or more second users; a purchase of one or more items, products, goods, or services by a first user for one or more second users; a request to add an item (e.g., one or more items, products, goods, or services) to a wish list of a first user by a first user; a request to add an item (e.g., one or more items, products, goods, or services) to a wish list of one or more second users by a first user; a request to add one or more friends to a system account or profile 130; a request to perform one or more social functions by a first user (e.g., which may involve, one or more second users); a request to recommend an item (e.g., one or more items, products, goods, or services) to one or more second users, and the like, without limitation.

According to some embodiments, an algorithm associated with one or more components of the system (e.g., system software 147) may be configured to perform the following step: receive, scan, analyze, process, store, manipulate, parse, and/or utilize message information contained within a “FROM” field, a “TO” field, a “CC” field, a “SUBJECT” field, and/or a message “BODY”, without limitation.

According to some embodiments, an algorithm associated with one or more components of the system (e.g., system software 147) may be configured to perform the following step: identify relevant system electronic address information contained within message information, and/or determine if certain system functions should or need to be performed, or are permitted to be performed, using the relevant system electronic address information, without limitation.

According to some embodiments, an algorithm associated with one or more components of the system (e.g., system software 147) may be configured to perform the following step: look for, identify, parse, process, and/or utilize: one or more words, keywords, commands, function codes, item codes, redemption data 64, and/or other functional relationships between message information which may suggest a function to be performed (e.g., which may be suggestive of functions regarding “LIKE”, “SEND”, “CREDIT”, “SHARE”, “TRADE”, “CASH”, “COST”, “PEEK”, “VOID”, “REDEEM”, “ORDER”, “RECOMMEND”, “WISH”, “FRIEND”, or the like), without limitation.

According to some embodiments, an algorithm associated with one or more components of the system (e.g., system software 147) may be configured to perform the following step: look for, identify, parse, process, and/or utilize: one or more strings comprising physical address information and/or electronic address information (e.g., one or more sequential characters or integers representative of mobile device numbers, IP addresses, global unique identifiers (GUID)s, email addresses, screen names, user IDs, handles, extensions, and/or the like), without limitation, wherein special characters (e.g., “@”, “(“,”)”, “−”, “ ”, “_”, “%”, “$”, etc.) may be identified, parsed, added, and/or removed, as necessary. It may be appreciated that the algorithm may be used to “scrub” user inputs 4 to avoid SQL injection, and/or configure or re-configure user entries into a usable format for use with system components (e.g., one or more databases), without limitation. For example, in some exemplary non-limiting embodiments, the one or more strings may comprise characters which may be representative of a 10-digit recipient, friend, and/or activating user's phone number, if the recipient, friend, and/or activating user's mobile device 96, computing device 95, or telephone is located within the USA).

According to some embodiments, an algorithm associated with one or more components of the system (e.g., system software 147) may be configured to perform the following step: look for, identify, parse, process, and/or utilize: one or more strings which may comprise redemption information 64; for example, one or more strings which might match “vanity” redemption codes, vendor ID numbers, or other types of redemption information 64 disclosed herein, contained within a system-integrated database 129, 136, 137, 138 (e.g., “SUB12”, “OLIVELUNCH”, “HERSHEYBAR”, “JIFFYOIL”, “REDBOX2”, “STJUDE”, etc.), without limitation.

According to some embodiments, an algorithm associated with one or more components of the system (e.g., system software 147) may be configured to perform the following step: look for, identify, parse, process, and/or utilize: one or more strings which may contain certain special characters; for example, such as “@” and a “.” (which may be representative of a recipient, friend, or activating user's email address), without limitation. It should be understood that one or more strings containing special characters like “$” may be representative of an amount of funds or credits to be sent (e.g., an amount of system funds or credit to be sent, or an amount of participating entity 65-recognized “store-credit” to be sent, e.g., “Walmart$25”, “Lowes$15”, “$McDonalds5”), without limitation. It should be understood that one or more strings containing special characters like “@” (e.g., with no “.” or “net” or “com” or “co” immediately adjacent thereafter, without limitation) may be representative of an electronic address, such as a social media address (e.g., “@JohnDoe”, “@JaneDoe”), without limitation.

According to some embodiments, an algorithm associated with one or more components of the system (e.g., system software 147) may be configured to perform the following step: look for, identify, parse, process, and/or utilize: one or more strings containing integers, for example, strings containing a “.”, but no “@”, and/or two whole integers after the “.” (e.g., which may be representative of an amount of credit to be transferred), without limitation. Other parsing algorithms may be used, without limitation, and the inventor has contemplated conversion of decimals (e.g., DOUBLE or FLOAT) to whole numbers (e.g., INT) to eliminate rounding errors, has contemplated conversion back from decimals to whole numbers, and has contemplated whole number inputs 4 in lieu of decimals (e.g., wherein “12481” might equate to “124.81”), without limitation.

According to some embodiments, an algorithm associated with one or more components of the system (e.g., system software 147) may be configured to perform the following step: look for, identify, parse, process, and/or utilize: one or more strings which might suggest a barcode-based UPC, SKU, UID, or other stock inventory management identification code (e.g., an 8-digit code, a 12-digit code, a 13-digit code, or a 14-digit code). According to some embodiments, an algorithm associated with one or more components of the system (e.g., system software 147) may be configured to perform the following step: look for, identify, parse, process, and/or utilize: one or more strings which might suggest a system-recognized redemption code (e.g., a 16-digit integer or character string comprising one or more numerals, alphanumeric characters, special characters, lowercase characters, uppercase characters, symbols, and/or the like), without limitation. In one embodiment actually reduced to practice, a redemption code may comprise a 16-digit integer as appreciated form the appended drawings, however, other forms of codes (including hyphens and/or other characters) are anticipated.

According to some embodiments, an algorithm associated with one or more components of the system (e.g., system software 147) may be configured to perform the following step: look for, identify, parse, process, and/or utilize: one or more strings which might comprise “ ” (spaces); wherein in some embodiments, the algorithm may, according to some embodiments, separate strings by “ ” (spaces), without limitation.

According to some embodiments, an algorithm associated with one or more components of the system (e.g., system software 147) may be configured to perform the following step: look for, identify, parse, process, and/or utilize: one or more strings which might comprise “@”; wherein in some embodiments, the algorithm may, according to some embodiments, separate strings by “before the @”, without limitation. According to some embodiments, an algorithm associated with one or more components of the system (e.g., system software 147) may be configured to perform the following step: separate strings by “after the @”, without limitation.

According to some embodiments, an algorithm associated with one or more components of the system (e.g., system software 147) may be configured to perform the following step look for, identify, parse, process, and/or utilize: one or more strings which might comprise an “@” but no “.” (e.g., which may be representative of a social media platform 93 profile 130′ or social media address), without limitation.

According to some embodiments, an algorithm associated with one or more components of the system (e.g., system software 147) may be configured to perform the following step look for, identify, parse, process, and/or utilize: one or more strings which might comprise social media platform 93 electronic address information (e.g., a Facebook profile ID number “69123615”), for example, within the same message or a follow up message which may contain a function code such as “RECOMMEND”, “FRIEND”, “ACTIVATE”, OR “LIKE”, without limitation.

In some embodiments, redemption data 64 (e.g., comprising one or more machine-readable codes) may be provided to a recipient user, wherein the redemption data 64 may contain machine-readable indicia generated by one or more system components, once a request from a sending user is received by one or more system components. The machine-readable indicia may be unique and proprietary, without limitation, and may contain any one or more of the group: embedded and/or encrypted redemption information 64, sender information, intended recipient information, item/product/good/service information, cost/price information, item code information, reimbursement/claim information, vendor or manufacturer-specific information (e.g., promo code or special key code), security PIN/password/pass code/passphrase information, instructions, and/or the like, without limitation. In some embodiments, a P-O-S payment terminal may be provided with system software 147, and/or a separate stand-alone computing device 95 such as a mobile device 3, kiosk 3, mobile phone, tablet, computer, or the like, may be provided with system software 147. The P-O-S payment terminal and/or computing device 95 may be employed by or otherwise provided to a participating entity 65, such as a redeeming entity. For example, in some embodiments, a computing device 95 may be configured with system software 147, which may include a system mobile application, for use with a mobile device 96. In some embodiments, a checkout employee manning a P-O-S payment terminal may scan or otherwise read the machine-readable indicia provided by a redeeming user to the checkout employee, and the system software 147 may facilitate delivery of information to the checkout employee such as: whether or not the redemption information is valid, and/or who the intended recipient is (e.g., such information like a recipient electronic address, phone number, email address, security PIN/password/pass code/passphrase, and/or the like, may be provided by one or more system components, to the checkout employee, for example via a user interface 106 of the P-O-S payment terminal being manned by the checkout employee, who may, in turn, ask the redeeming user to provide such information, and may compare the system-received information with the redeeming user-provided information, in order to authenticate user credentials 8 and validate a transaction). In some non-limiting embodiments, software/scripts/plug-ins 147 may be provided to, installed on, or otherwise employed by online marketplaces and online retailers of items, products, goods, and services, in order to allow recipients of redemption information 64 to provide/enter redemption information 64 (e.g., redemption code information, personal information, user data 8, sender information, intended recipient information, item/product/good/service information, cost/price information, item code information, reimbursement/claim information, vendor or manufacturer-specific information (e.g., promo code or special key code), security PIN/password/pass code/passphrase information, and/or the like), without limitation. For example, one or more user data entry fields may be provided on a web page (e.g., a checkout web page) for receiving redemption data 64. In some embodiments, a specialized browser 131 on a mobile device 96 or computing device 95 comprising system software 147 may be configured to receive machine-readable indicia captured by a camera device (or other reader means 102, 110) provided to the respective mobile device 96 or computing device 95, may be configured to decode information contained within the machine-readable indicia, may be configured to decrypt/processes the decoded information, and may import the decrypted/processed information to the web page for submission to the participating entity's server 136 which may be configured with system software 147. In some embodiments, user interface 106 components of the system may comprise voice recognition/interpretation software which may receive and process redemption information 64 provided by a user verbally, without limitation.

In some embodiments, redemption information 64 which may be sent to recipients may be purchased by the system, for example, directly from the respective manufacturers or service providers 65 of items, products, goods, and/or services, according to user agreements between the system and the manufacturers/service providers 65. According to some embodiments, the redemption information 64 may be purchased by the system immediately upon a transaction request by a user, and then delivered to one or more recipients indicated by the user. According to some embodiments, the redemption information 64 may be purchased by the system upfront, before a user transaction request by a user, and then delivered to one or more recipients indicated by the user without limitation. In some embodiments, the manufacturers/service providers 65 may charge or invoice the system upon an end use/redemption of redemption information 64 by a system user in exchange for one or more items/products/goods/services affiliated with the delivered redemption information 65 (e.g., on the transactional back end).

In some non-limiting embodiments, the system may deduct a predetermined amount of credit (e.g., a suggested manufacturer's retail price of an item, product, good, or service) from a sending/requesting user's 91 account balance which may be associated with the sending user's profile 130, wherein the deducted predetermined amount of credit may be applied to redemption information 64 pertaining to a item/product/service to be sent to and used/redeemed by a recipient. In some embodiments, the deducted predetermined amount of credit may further comprise an optional transaction fee and/or user tax fee, without limitation.

In this regard, if there is a difference between the redeeming party's 65 sales price (or if the redeeming party 65 may be subject to local tax implications of the transaction regarding exchanging one or more items, products, goods, or services in exchange for system redemption information 64) and the price paid to the system by the sending/requesting user 91 (e.g., via the deduction of a predetermined amount of credit), the redeeming party 65 may be made whole by the system. Else, in some embodiments, a redeeming party 65 may be made whole for differences in a system price of redemption information 64 and a redeeming party's 65 sales price of an item, product, good, or service associated with the redemption information 64, by the redeeming user 92 of redemption information 64 paying the small difference in cost (which may be insignificant, and/or may be less than respective shipping and handling costs which might have been necessary using more traditional gifting-by-mail methods known in the art). In some embodiments, the system may be integrated with a large third party 65 marketplace (e.g., Wal-Mart, Amazon.com, Kroger foods, etc.) which may cooperate with the system (e.g., via a participating user 65 system agreement), wherein when the system receives a request from a user 91, 92, the system may provide the participating marketplaces 65 with transaction information relating to the request; wherein using the transaction information, the third party marketplace 65 may carry out the transaction on behalf of the system and/or the user 91, 92. The actual business model(s) regarding how parties (users 91, 92 of the system, the system, redeeming parties 65 (e.g., online or brick-and-mortar retailers or service providers), manufacturers, and the like) are made whole and/or reimbursed may vary, without limitation, so long as the uses and/or functionalities of the inventive methods and concepts described herein, facilitated by the appropriate hardware, software, and/or communications apparatus components, may be realized, without limitation.

In some embodiments, the system may allow a user to “cash-out” credit received from a sending user, or, in some embodiments, the system may allow a user who may not want to participate in the system any longer, to “cash-out” some or all credit associated with the user's system account balance (e.g., balance associated with the user's profile 130). For example, in some embodiments, a user may send an electronic communication to the system (e.g., an electronic message communication to a system address) comprising one or more instructions to “cash” or “trade” system credit and/or redemption information 64. The electronic communication may comprise an amount. The system may, in response to receiving the electronic communication, deliver one or more instructions to the requesting user which might be necessary to credit the requesting user (e.g., require input 4 of bank account information, routing information, mailing address, name (for mailed check), and/or the like, without limitation). In some embodiments, a user 91, 92 may make such an electronic communication via a system mobile application 147 provided to the user's mobile device 96 or computing device 95. In some embodiments, In some embodiments, a user 91, 92 may make such an electronic communication via a system website 127, for example, after providing credentials to a system website 127 web page. Credentials may be employed in any manner shown or described in this disclosure. In some embodiments, participating entities 65 (for example, retailers which may sell a system card 19 (e.g., “ShareCard”) may provide cash and/or store credit to a user which may amount to a total balance of user credit associated with the user's system account balance. In some embodiments, participating entities 65 may provide cash and/or store credit to a user which may amount to a portion of the total balance of the user's credit (e.g., only 50%, 75%, or 85%, etc.). Such functions may be facilitated by system software 147 which is configured to access and/or manipulate a system database 129 comprising the user's profile 130 and system account information, without limitation. In such embodiments, users 91 may be inclined to utilize their system credit and/or unused redemption data 64, and/or deplete their system credit and/or unused redemption data 64, rather than cash or trade it for another tangible monetary form. In some embodiments, users may add funds to their system accounts online, by accessing a system website 127 from a computer 95 or mobile device 96 (e.g., a smart phone) and paying with credit card, bank card, check, or other financial service (e.g., PayPal) as conventionally done for online purchases made on a secure HTTPS checkout page. In some embodiments, users may add credit to their system account via a system mobile application 147. In some embodiments, a user may add system credit to their system profile 130 account 48 at participating entity 65 brick-and-mortar facilities, by providing one or more of their existing system cards 19 to a P-O-S checkout register/payment terminal and “reloading” it with credit by providing additional funds (e.g., payment data 10) to the P-O-S checkout register/payment terminal; wherein system software 147 associated with the P-O-S checkout register/payment terminal may access the system database 129 and update the user's account balance, without limitation. In some embodiments, a user may add system credit to their system profile 130 account 48 at a participating entity 65 brick-and-mortar facility, by purchasing a new system card and activating it and “reloading it”, wherein the user may activate the card by providing one or more electronic message communications to the system, and components of the system may identify the incoming user's electronic address (e.g., phone number or email address), components of the system may determine that the identified incoming user's electronic address is an existing user, and components of the system may update the appropriate row/column/field in the system database 129 associated with the user's electronic address to reflect the newly “increased” system credit balance and/or the new card 19 information, without limitation. In some embodiments, a user may add system credit to their system profile 130 account 48 at a participating entity's brick-and-mortar facility, by providing one or more of their existing system cards 19 at a P-O-S checkout register/payment terminal and “reloading” in a similar manner as described. It should be understood that other than providing one or more system cards 19 to a P-O-S checkout register/payment terminal 100, audio data 7 and/or image data 6 may be provided to one or more components of the system 3, 95, 96, 100, 106, 127, 131 which contains payment information 10 and/or a system account information (e.g., a system account number, user data 8, or the like), which may be received, read, interpreted, processed, and/or used by system-integrated software 147 to complete the transaction, without limitation.

In some embodiments, a user 91 may forward a redemption code directly to another user(s) 92 (e.g., “re-gift” a pre-purchased system redemption code) via SMS/MMS/email/social media direct message, voicemail, etc., without consequence. In some embodiments, a user 91 may forward a redemption code indirectly to another user(s) 92, for example, by submitting an instruction to the system notifying the system of the recipient's number and the respective redemption code(s) to be sent to the recipient's number, without limitation. In some embodiments, a user 91 may re-gift a redemption code to another user(s) 92 at a small penalty or fee. In some embodiments, a user 91 may re-gift a redemption code to another user(s) 92 without a penalty or fee. The step of submitting an instruction may, in some embodiments, comprise a re-gift request. The re-gift request may be web-based (e.g., via a system website 127 or mobile application 147, without limitation), or it may be electronic message-based (e.g., by sending a social media post, text, email, voicemail, phone call, or the like, without limitation). In some embodiments, the request may be made in a similar manner as done for other function codes (e.g., by submitting one or more instructions to the system notifying the system of one or more electronic addresses of a recipient(s), a desire to “re-gift” (this may be communicated in many ways, such as by conforming to a re-gift convention or by providing a system-recognized command as will be appreciated from the figures), and the pertinent redemption information 64 to be re-gifted). For example, a re-gifting user 91 may send an email to “regift@send1now.com” or “request@send1 now” (i.e., a system electronic address) wherein the email may contain one or more redemption codes to be re-gifted, and one or more new recipient electronic addresses (if one or more PINs are required by a redeeming merchant 65 in combination with the one or more redemption codes, the system may send one or more PINs to the one or more new recipient electronic addresses). According to some embodiments, re-gifted redemption codes and/or PINs associated therewith may be changed to prevent misuse of re-gifted redemption codes by gifting users 91. Alternatively, a user may text a redemption code to be re-gifted to a system short code or system email address specified by the system, along with intended recipient information. The system may change the redemption code upon a “re-gift” request, thereby ensuring to the requester 91 that the transmission may be secure. In some embodiments, a recipient of a re-gifted redemption code(s)/PIN(s) may be provided with an opportunity to decline or provide a “thank-you” gift in return, without limitation. Alternatively, in some embodiments, a user may copy an SMS/MMS/mobile message containing redemption information 64, or may copy redemption information 64 contained within a system-received SMS/MMS/mobile message, may paste it into a new SMS/MMS/mobile message addressed to a system electronic address, may add a re-gift instruction (e.g., “REGIFT”) in the SMS/MMS/mobile message addressed to a system electronic address, and may send the SMS/MMS/mobile message to the system electronic address, in order to receive instructions back from the system (e.g., further instructions from the system on how to complete the re-gifting process). Alternatively, in some embodiments, a re-gifting user 91 may reply to an email containing a redemption code with the word “REGIFT” in the subject field and/or in the body of the email, and one or more new recipient email addresses in the CC field, subject field, and/or body of the reply email; wherein upon sending of the reply email, one or more system components may receive the reply email, parse the information contained within the reply email, and perform one or more re-gifting transactions or functions based upon the parsed information, without limitation. Alternatively, in some embodiments, a user 91 may copy an SMS/MMS/mobile message they received from the system (e.g., copy or save the complete message or portions thereof, without limitation) and may optionally forward the SMS/MMS/mobile message or portions thereof, or otherwise communicate information pertaining to the received SMS/MMS/mobile message to one or more other individuals directly, for example, without the use of an indirect communication sent directly to the system, without limitation. A plethora of manners in which users 91, 92 could conceivably communicate required information to the system in order for the system to perform the types of transactions described herein may be utilized, without limitation.

It should be noted that the inventor contemplates that the inventive methods, concepts, and benefits of the system and components thereof could be utilized with financial institutions (e.g., banking institutions and credit institutions), and may be employed similarly by the financial institutions (albeit, the manner(s) in which a user account is “charged” or otherwise “loaded” with credit may differ). In some embodiments, a user 91, 92 may fund their system account balance while logged into a website of their financial institution 163 (e.g., via electronic transfer funds transfer), or their system account may be linked with their financial institution account, or the system account may comprise their financial institution account, without limitation. In some embodiments, a new credit card being issued to a loyal member of a credit card company may be able to utilize components of the systems and methods described herein. Moreover, a new bank card (e.g., debit card) being issued to a loyal member of a credit card company may be able to utilize components of the systems and/or any of the methods described herein. In such instances, the large banking and credit institutions may enjoy the benefit of utilizing system functionality to draw potential new customers and members. For example, Chase Bank, Discover Card Financial, or Wells Fargo may offer a new “card” or “account” product which may allow their “cardholders” or “account holders” to perform some or all of the inventive functions described herein (and related or co-pending applications to this one). In short, in some non-limiting embodiments, a system-independent proprietary card 19 (“gift card”, “pre-paid” card, or “stored value” card) to load account funds may not be absolutely required, nor may a system server 128 or database 129 be absolutely necessary (so long as another server 122, 125, 136 and database 136, 137, 138 can perform similar functions). Moreover, any one or more of the system components and/or method steps described herein may be licensed to financial institutions, as well as other entities (e.g., large retail chains), without limitation, wherein the financial institutions and/or other entities may essentially comprise “the system” or a “system entity”.

In the event a card is lost or stolen, a user may, in some embodiments, report the same to temporarily deactivate the account. Secure transmission of communications (e.g., secure email, encryption, SMS-based) may be required for such activities. In some embodiments, a card 19 may not have any value after it has already been activated by a user 91, because the funds and other information associated with the card 19 may have already been associated with the user's electronic address. In some embodiments, if a user 91 with a first electronic address wishes to purchase a new system card 19 (e.g., to replace a lost system card or to add funds to their system account 48), the system may transfer or otherwise “add” a remaining existing balance of credit associated with the first electronic address to added funds associated with the purchased new card 19, and the system may associate the resulting total balance with the first electronic address and with information pertaining to the purchased new system card 19 in the system database 129. Accordingly, if the new card is activated with the same first electronic address (e.g., email address or mobile phone number) already on file, the process of obtaining a new card may be facilitated. It should be realized that a user's unique IP address or GUID could be used as a user electronic address which could be associated with a user's profile 130 information (e.g., account balance, redemption 64 credits, user data 8, and/or account information), without limitation. IP address or GUID information may, in some embodiments, be used to identify and/or confirm a user's identity (particularly for web-based request communications between users 91, 92 and the system via a system website 127, for web-based request communications made between users 91, 92 and the system via a mobile application 147, and for P-O-S terminal communications made between participating entities 65 and the system via system software 147, without limitation).

Redemption codes described herein may apply to any item, product, good, or service in existence, and is not expressly limited to items having a physically printed label or UPC code affixed thereto. Redemption codes may be purchased and/or gifted for various things (e.g., five dollars towards next Redbox rental(s) using system item code “REDBOX5”, eight dollars toward Ross merchandise using system item code “ROSS8”, stadium grass seating for a Cubs baseball game using system item code “CUBSGRASS”, free music lesson from Guitar Center using system item code “GCLESSON”, a free song download from iTunes using system item code “1DOWNLOADITUNE” or five free song downloads from iTunes using system item code “5DOWNLOADITUNE”, etc. . . . ). The inventor contemplates many uses for embodiments of the system for various types 75 of redemption data 64 pertaining to a variety of participating entities 65, without limitation, and foresees great benefits to consumers, merchants, service providers, and manufacturers, alike, in having a single universal system to perform everyday transactions outside of purely money transfer transactions. In a way, certain embodiments may be appreciated as combining the ease and convenience of social networking, with privacy features enjoyed with cryptographic currency and/or in-person gifting, as well as the functionality of performing online purchases, without necessarily comprising the hassles of: creating numerous separate user accounts; maintaining numerous passwords, login IDs, or other credentials; providing personal financial information to numerous online vendors; and/or having to necessarily be “online” to purchase something for another (remote) person.

According to some embodiments, users 91, 92 may log into a system website 127 or use a system mobile application 147 to enter redemption information 64 (e.g., one or more redemption codes) in one or more provided fields, via a user interface 106, to display and review a list of local participating redeeming entities 65 (retailers, restaurants, brick-and-mortar marketplaces, online marketplaces, etc.) which may honor the redemption information 64. According to some embodiments, as a preference 63, users 91, 92 may select one or more particular participating redeeming entities 65 which they may desire to use in order to redeem redemption information 64, and this may expedite and/or facilitate the redemption process. According to some embodiments, users 91, 92 may select a particular participating redeeming entity 65 which they may want to use to redeem redemption information 64, in order to speed up or facilitate the redemption process. In this regard, upon receipt of participating entity 65 information, user data 8, and respective redemption information 64, as a user input 4, the system may, as an output 5, notify the selected participating redeeming entity 65 that a redemption by the user is forthcoming, for example, by sending an electronic communication to an electronic address of the selected participating redeeming entity 65, the electronic communication comprising data 8 pertaining to the user and/or the respective redemption information 64 to be used with the selected participating redeeming entity 65. In some embodiments, via a user interface 106 component of the system, users may select one or more participating redeeming entities 65 as “home stores”, for example, to automate a redemption process(es), including a future use(s) of redemption information 64 (e.g., redemption codes received in the future). For example, if a user prefers to have their future-received redemption codes to be delivered from a specific favorite participating entity 65, and/or if a user prefers to have items/products/goods/services delivered or picked up in-store in exchange for future-received redemption codes, they may select one or more participating redeeming entities 65 (e.g., Amazon.com, Overstock.com, Walmart.com, or other online retailer) which are to be their ‘default’ participating redeeming entity(ies), without limitation. In such instances, the system may work directly with default participating redeeming entities 65 (e.g., indirectly with users 91, 92), may provide, receive, and/or share relevant recipient information, item code information, and/or redemption information 64 with the participating redeeming entities, and/or may reimburse the participating redeeming entities for transactions made by respective users. In other words, the system may act as a facilitator or “middle man” to assist with transactions made by users who prefer to use the simple and easy “text”-based, “email”-based, application-based, social media based, and/or phone call-based requests offered by embodiments of the system described herein. Upon receiving a user transaction request, the system may check all participating redeeming entities 65 in the profile 130 associated with the user making the transaction request, which have previously agreed to process back-end transactions for certain items, products, goods, or services. The system may then relay such information to an end recipient involved in the user transaction request, in an electronic communication to the end recipient; wherein the end recipient may, in some embodiments, chose one participating redeeming entity 65 from the relayed one or more of the participating redeeming entities 65; wherein information pertaining to the chosen participating redeeming entity 65 may be conveyed back to the system from the end recipient, for example, in a subsequent communication; and/or wherein the system may return redemption information 64 to the end recipient which pertains to the end recipient-selected participating redeeming entity 65, without limitation. In some embodiments, the end recipient 92 may have little or no choice regarding what redemption information 64 will be sent to the end recipient 92 (e.g., choice regarding a type(s) of redemption information 64 and/or choice regarding a default participating redeeming entity(ies) which is to be used when using/redeeming redemption information 64 pre-purchased by a sending user 91), without limitation. In some embodiments, the system may offer one or more participating redeeming entities 65 classified as user-indicated “first preferred” default participating redeeming entities, the first right of refusal to process a transaction request made by a user through the system using system components and/or methods, without limitation. In some embodiments, if the one or more “first preferred” default participating redeeming entities do not wish to process a transaction, after being offered a first right of refusal to process the transaction, the system may contact one or more “secondary” participating redeeming entities (e.g., those which may be “less preferred” by users), without limitation, to determine if they wish to process the transaction. Preferred participating redeeming entities 65 may be set up, for example, as a user preference 63 in a user profile 130 stored on the system database 129.

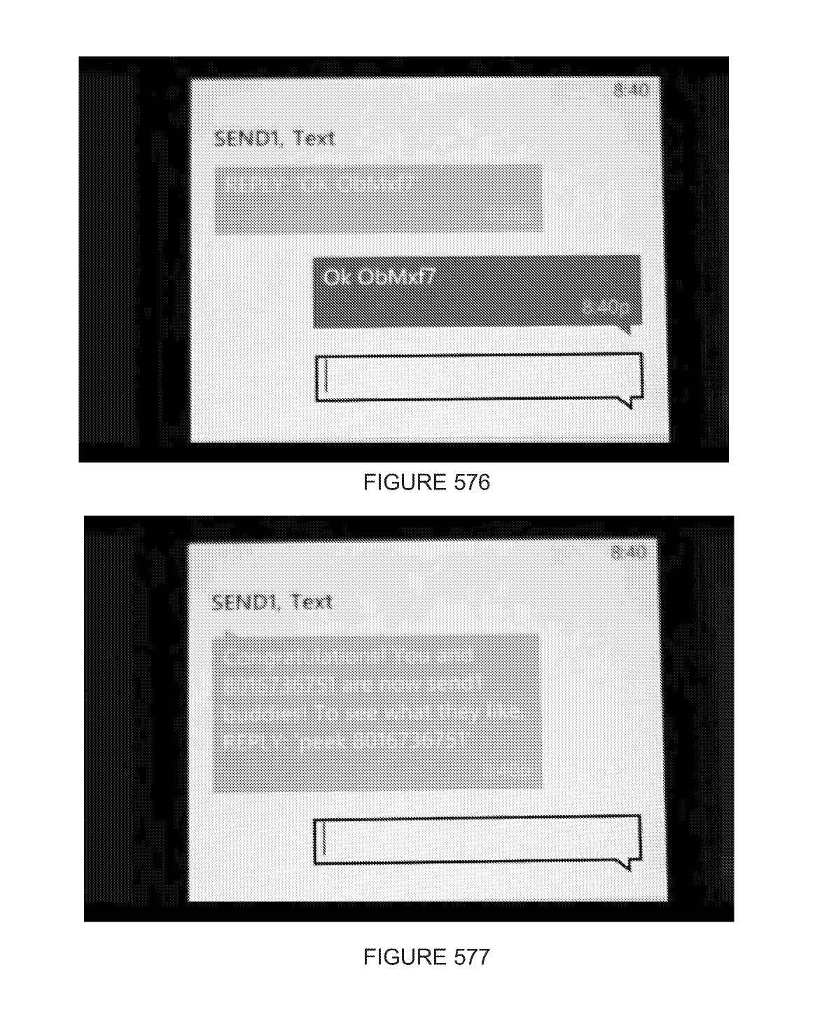

In some instances, users may enter friend information by logging into a system account on a system website 127; by sending an email (e.g., to “addfriend@send1now.com” or “request@send1now.com) containing friend contact information, such as an electronic address of one or more friends; by texting the friend contact information to a system electronic address (e.g., a system short code); and/or by entering a friend's electronic address information by keypad or voice command by calling a system hotline and following one or more “friend” prompts, without limitation. Upon system components receiving and processing such friend requests, system components may electronically deliver one or more electronic communications to the one or more requested “friends” (e.g., via a system website 127 profile 130 interface 106, via a mobile application 147 alert, and/or via an electronic message (e.g., an email or text-based message to the friend's mobile device 96 or computing device 95, without limitation)). For example, system components may deliver a message to the requested “friend(s)” to confirm that they know the requester (e.g., based upon the requester's electronic address). In some embodiments, the contacted “friend(s)” may reply “Y” or “N” to the system-delivered message to confirm they are, indeed, comfortable with the requesting user. In some embodiments, the contacted “friend(s)” may reply to the system-delivered message with a code or other command in response to one or more instructions provided in the system-delivered message (e.g., “0k 0bMxf7” as shown in FIG. 576) to confirm they are, indeed, comfortable with the requesting user being a “friend” through the system. Thereafter, in some embodiments, the requesting user may have access to the wish list(s) of the added “friend(s)”. In this regard, users may be able to gain some insight on what system item codes (and/or items, products, goods, or services thereof) are favorable to certain friends, contacts, or relatives, thereby possibly facilitating gifting decisions and/or personalized sharing functions for the users, without limitation.

In some embodiments, a user's account may be linked to an internet TV, or “box-top” cable TV account, wherein during system-supported commercial advertisements, paid programming, and/online shopping, one or more pop-ups or selectable icons may be provided on a portion (e.g., a lower or corner portion) of a television display indicating a transaction instructions (e.g., “To purchase this with your send1 ShareCard now, press the “OK” button now”, without limitation). The partnering internet TV, or “box-top” cable TV service provider 65 may, via a digital processor and software, communicate the request information input 4 to the system server 128, so that the system software 147 can process the transaction for the user. One or more response communications (e.g., a confirmation request or delivery of electronic receipt information) may be delivered back to the user and displayed on the television display (e.g., via the service provider's server 136, software 147, a processor, and user interface 106 provided to the television). Other forms of electronic receipts 20 may be simultaneously or subsequently delivered to one or more electronic addresses associated with the user's service provider 65 and/or system account as an output 5 to the user inputs 4 (e.g., as a more permanent receipt 20 form). In some embodiments, similar method steps may be performed for gifting transactions involving other users. In some embodiments, system software 147 may be installed to the TV as an application 147. In some embodiments, system software 147 may be installed on the service provider's server 136, 137. In some embodiments, pressing the “OK” button may, for example, prompt the system to send one or more electronic communications (e.g., email, text, call, voicemail, social media posts, or mobile application communications) to the user's mobile device 96 or computing device 95 (preferably via SMS to the user's phone) confirming the purchase and/or prompting the user for recipient information (if applicable for a gift) or providing further instructions which may be necessary to complete the transaction. Alternatively, system software 147 may be provided to the partnering internet TV, or “box-top” cable TV service provider 65 so that when the “OK” button is pressed, a system menu (e.g., similar to the user interface 106 of the system website 127 and/or mobile application 147) pops up on the television display. In some embodiments, the user may, using a remote controller or mobile application 147 provided to the user's mobile device 96), select a “friend” from a friends list to indicate a recipient, and/or the user may select an icon representing “buy” (e.g., an icon “send1 to me”, or the like) to have the respective item, product, good, or service purchased and electronically or physically delivered using funds from a prepaid system account 48, system card 19, system-compatible credit card, system-compatible debit card, or third party account 48 (e.g., a service provider account such as an account associated with the partnering internet TV or “box-top” cable TV service provider 65, or an account associated with a mobile device 96 service provider account, e.g., “mobile billing”). According to some embodiments, a mobile application 147 provided to a mobile device 96 which can communicate with a television (e.g., a smart TV or box-top set) and/or television programming (e.g., a mobile device remote configuration) may be, according to some embodiments, configured with similar functionality, to perform similar transactions, without limitation. For example, in some embodiments, the mobile application 147 may comprise an “OK” button, wherein when a particular program or commercial is playing, and the “OK” button is pressed, the mobile application may display one or more prompts for a user to select as an input 4. In some embodiments, the one or more prompts may pertain to a particular item, product, good, or service being displayed by the television at the moment the “OK” button is pressed. For example, one or more prompts to buy, gift, like (e.g., “thumbs up”, “vote up”), recommend, and/or add to a wish list 144a or shopping list 144 may be displayed for interaction with the user of the mobile application 147 of the mobile device 96. Pressing indicia or otherwise operably engaging buttons associated with the one or more prompts provided on a user interface 106 of the mobile application 147 (e.g. as user inputs 4), may provide one or more instructions to system components (e.g., system server 128, system software 147) to execute one or more functions as outputs 5 associated with the one or more respectively selected prompts. For example, a user watching a commercial may see a product they like, press the “OK” button, and be confronted with a list of prompts via a user interface 106 of the mobile application 147. In some non-limiting instances, the user may, for example, select or operatively engage a “gift” icon or indicia representative of a gifting function in response to a displayed prompt, and the mobile application 147 on the mobile device 96 may bring up the user's mobile contacts list (e.g., imported from the mobile device's SIM card, drive, or other memory on the mobile device 96). In such an instance, the user may, for example, select one or more of the contacts from the user's mobile contact list (e.g., as recipients), and press a submit button or the like (e.g., “send1 now”). According to some embodiments, upon pressing a submit button as a user input 4, an optional confirmation page may be presented. The selected contacts information may be received by the mobile application 147, and delivered electronically to a system-integrated server 128 via a communications network 118 (e.g., a cellular-based data network). Using GUID information, electronic address information, electronic signature or the like, system software 147 may determine the identity of the user, may check the user's profile 130 in a system database 129, may determine and verify funds or credits in the amount of the gifted item/product/good/service multiplied by the number of selected recipients from the contact list (e.g., total amount due), may deliver a failed transaction confirmation communication if there are insufficient funds, may deliver a successful transaction confirmation communication (e.g., an electronic receipt 20) if there are sufficient funds, may deduct the total amount due from the users account 48 associated with the user's profile 130, and/or may deliver redemption information 64 pertaining to the respective item/product/good/service, to each of the selected recipients, without limitation. For example, a system server 128 may access database 129, 135, 137, 138 information, debit an account of the user (e.g., system account, mobile billing/service provider 64 account, financial institution account, and/or the like, without limitation) in an amount equivalent to the cost of the item/product/good/service multiplied by the number of selected contacts, and then send one or more electronic communications (e.g., electronic messages) to each of the selected contacts (e.g., to one or more electronic addresses for each recipient), the one or more electronic communications containing redemption information 64 pertaining to the item/product/good/service (e.g., a prepaid electronic voucher information which may used to redeem the item/product/good/service). It should be understood that discounts may be applied for the item/product/good/service purchased, without limitation. It should also be understood that in some embodiments, the redemption information 64 may be partially paid for by a gifting user, wherein recipients of the redemption information 64 may be required to pay a difference between a participating entity's 65 sales price for the item/product/good/service and a value of the redemption information, without limitation. Communications made to each of the selected contacts via system components 118, 147 may, in some embodiments, be sent via email, SMS, MMS, mobile messaging, voicemail, social media platform, or to a website 93, 127 profile 130, 130′ of respective selected contact recipients, without limitation. In some embodiments, if a selected contact has multiple electronic addresses associated with it, the same redemption information 64 may be sent to each of the multiple electronic addresses associated with the respective selected contact. Other variations and obvious permutations of the aforementioned method are anticipated. For example, while an “OK” button has been used for illustrative purposes, another type of button or indicia may be utilized (e.g., a “send1” button), without limitation.

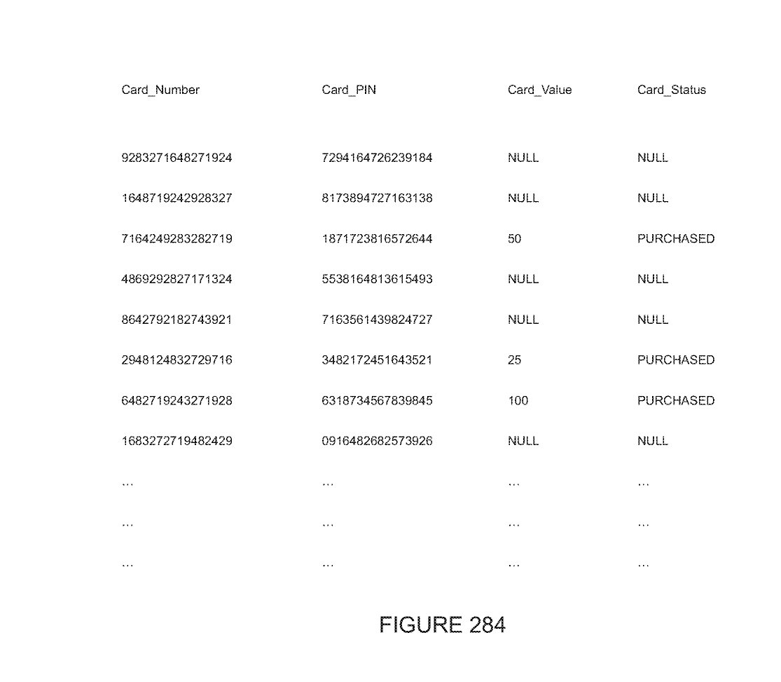

As suggested in non-limiting FIG. 284, database tables may include columns such as card number, card PIN, card value, card status, as well as type (not shown), without limitation. For example, one or more type columns or a field within a type column may include data associated with one or more physical cards and/or electronic cards of a system user 91, 92 (e.g., cards which may be purchased online or in-store to create a system profile 130 account 48 and associate funds or credit (e.g., “system currency”) with the system account, and/or third party cards, such as a system user's bank, credit, and/or debit cards), without limitation. A number of pre-generated card numbers and associated PINs may be created in such a table, without limitation. Card numbers shown are sixteen digit integer strings; however, card numbers may comprise any length of string containing any one or more types of characters, symbols, upper case letters, lower case letters, etc., without limitation. For example, card numbers and/or card PINs may resemble a GUID (e.g., “99b5af51-673d-4692-8mdf-fr5c9654548a”) or portions thereof, without limitation. When a user purchases a card 19, a card 19 status may be updated from NULL to PURCHASED via system software 147 (e.g., provided to a website host server or to a participating entity's 65 payment terminal 100), and the card value may be updated, based on the value amount paid for in conjunction with the card 19 purchase. In some embodiments, a separate database table(s) listing all un-purchased system cards 19 may be created, indexed, and/or selected from; for example, wherein one or more separate tables may exist for “new” or “inactivated” physical/electronic cards, and, wherein upon purchase by a user, row information from one or more “new” or “inactivated” physical/electronic card tables may be removed from respective tables and may be placed into or otherwise added to one or more “activated” system account tables, where user information 8 (such as electronic address information) may be associated with a respective card and/or card PIN upon purchase of a card 19, in one or more “activated” system account tables. In some embodiments, separate tables may exist for physical cards and electronic cards, without limitation.

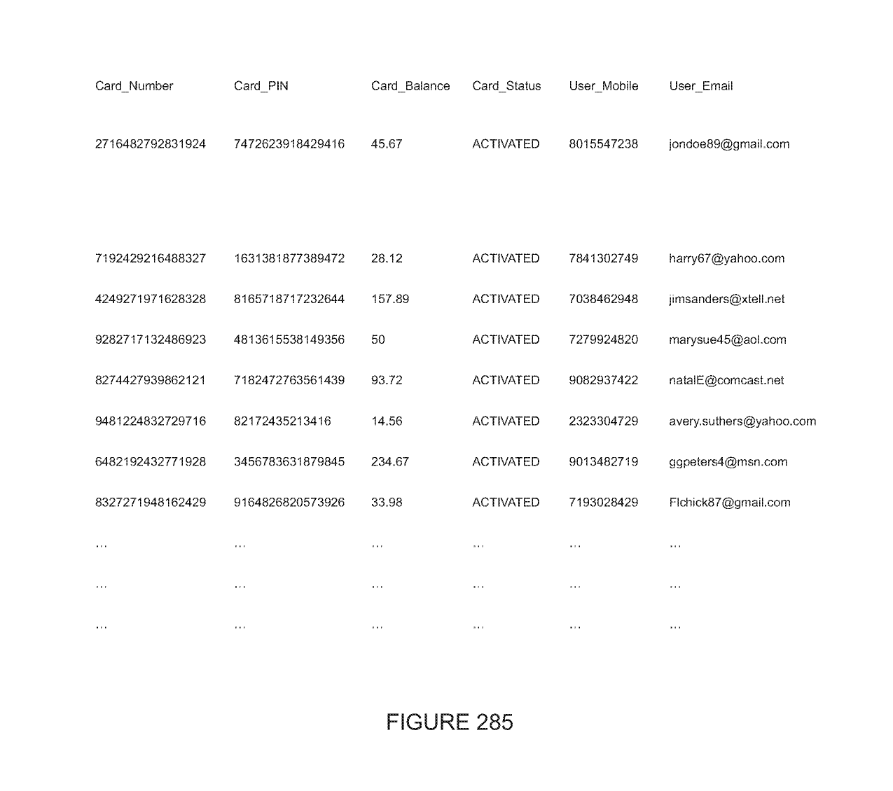

As suggested in non-limiting FIG. 285, an “activated” system user profile 130 and/or a system account table may be held in one or more system-integrated databases 129, 135, 137, 138 and may comprise user electronic 53, 49 and/or physical address 54 information, as well as preference 63 information, transaction information 90, credits/redemptions information 64, etc, without limitation. The database(s) may comprise “pointers” or additional table information, such as one or more table names which contain additional user information. While not shown, table entries (e.g., “cells” or “fields”, or “row information”) may comprise multidimensional arrays, without limitation. As shown, user electronic address information (e.g., user mobile numbers and/or email addresses) may be linked to a user's card 19 information and system account balance. It should be understood that embodiments of user profiles 130 may comprise many other forms of database architectures or variations from the particular form disclosed, without limitation.

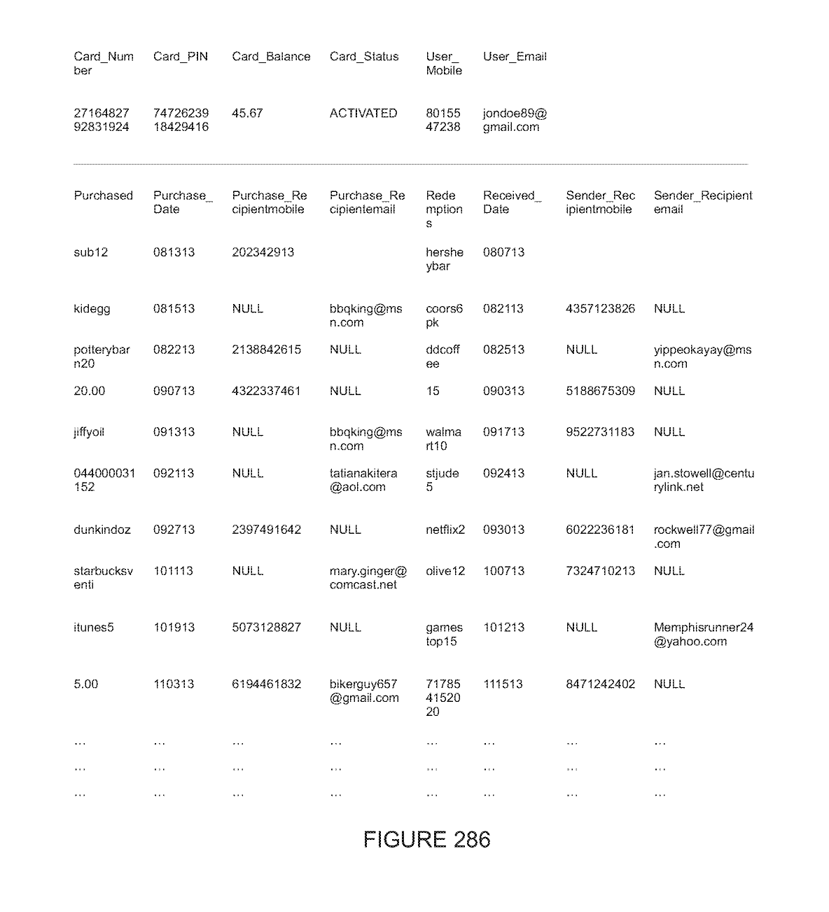

As suggested in non-limiting FIG. 286, each system user 91, 92 may be assigned his/her own database table comprising his/her own profile 130 information. It should be realized that any existing platform(s), method(s), or database management software known in the art may be employed with embodiments, without limitation. As shown, such a table may include metadata 90, past transaction information, user data 8, purchase data 10, redemption data 64, purchase dates 69, redemption dates 68, received dates, recipient information, and sender/purchaser information, as well as item code information or credit transfer information (e.g., amounts) pertaining to various transactions, without limitation.

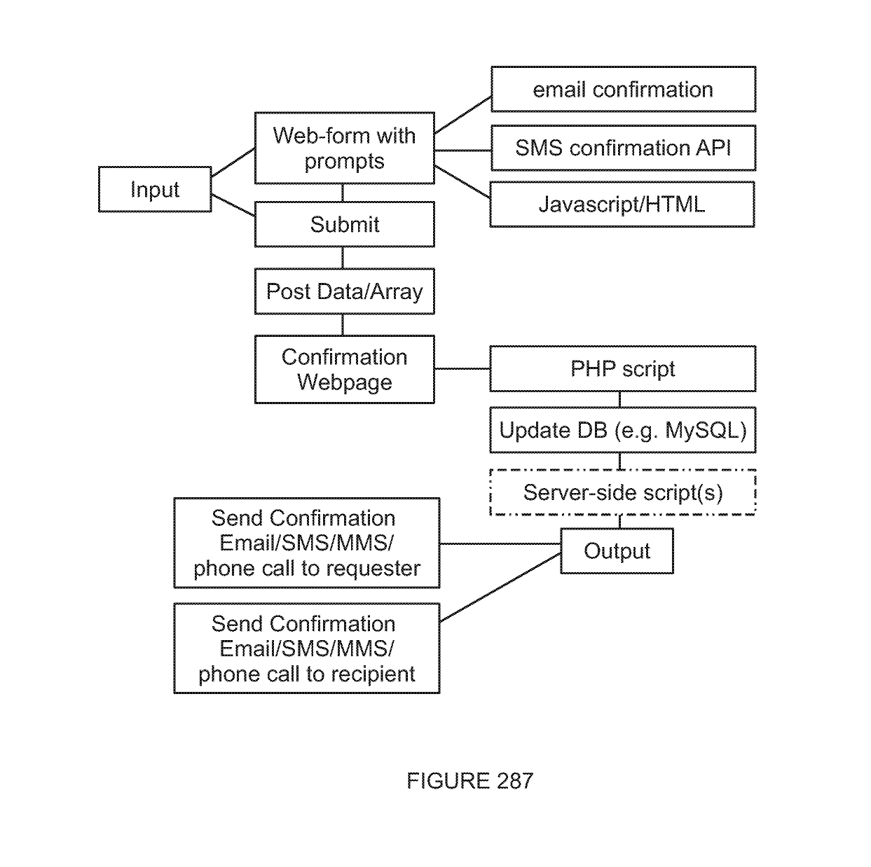

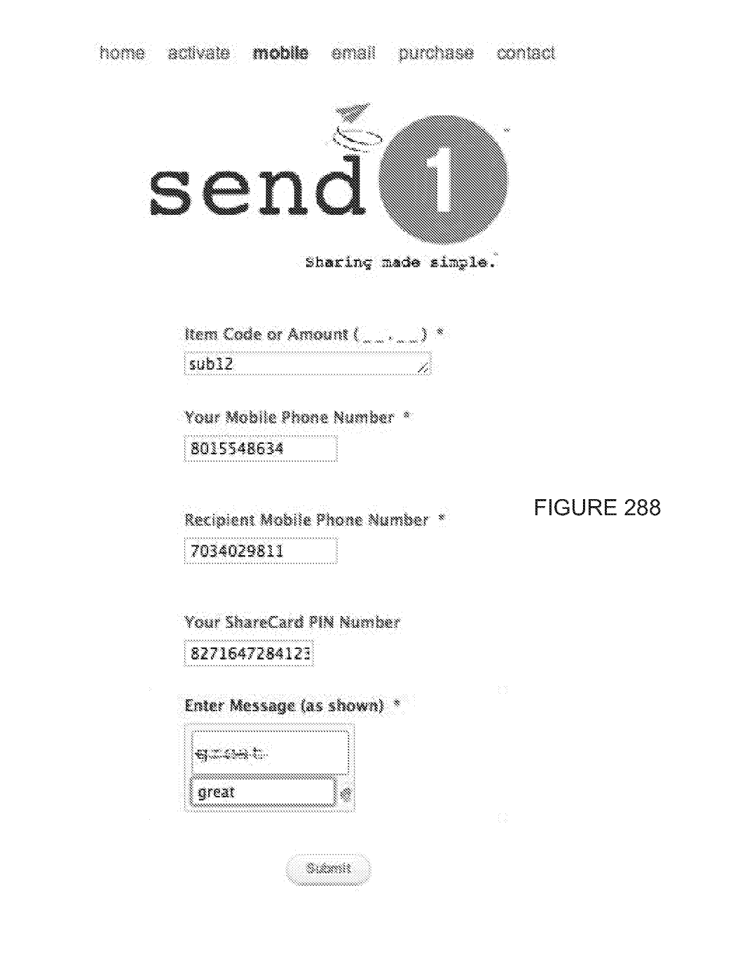

As suggested in non-limiting FIG. 287, a system platform component may comprise a web-form (e.g., as shown in FIG. 288) accessible by a mobile device 96 or computing device 95 (e.g., wearable computer, tablet, laptop, desktop computer, gaming system, cable or internet television system/device, payment terminal system, etc., without limitation). The web-form may comprise web pages having fillable forms which may be populated by voice command or by manual/tactile input 4 via a user interface 106 or component thereof. The web-forms may run/operate on different types of code, which may comprise JavaScript, HTML, PHP, .net, or other web-based programming language known, without limitation. Upon submission of information, web-forms may automatically generate electronic confirmations with POST data obtained from the form submission (e.g., electronic messages, such as email receipt message communications). The confirmations may, in some embodiments, go to system inboxes and/or user inboxes (e.g., sender and/or receiver email inboxes, phone inboxes via SMS/MMS messaging, user profile 130 inboxes—including social media 93-based profile 130′ inboxes, without limitation). In some embodiments, means for human verification may be employed, (e.g., Captcha software widgets and fields). In some embodiments, one or more SMS services, third-party platforms, and/or APIs may be integrated with system components (e.g., system hardware 128 and/or software 147), without limitation. Such system “add-ons” may, in some embodiments, be used to confirm requesting user identification (e.g., a “confirm” button may be provided adjacent a field which is configured to receive a one-time delivered SMS pass code as a user input 4), without limitation. While a simplistic embodiment is shown, less or more fields, or a number of redundant fields may be provided to improve security, without limitation.

According to some embodiments, system “add-ons” (e.g., one or more SMS services, platforms, or APIs) may include, without limitation, one or more of the following: #blue API: Text messaging storage service, 2-WaySMS API: SMS messaging service, 2sms API: SMS messaging service, 360Text API: SMS text messaging service, 3Jam API: Reply-all text messaging service, 411Sync API: SMS, WAP, and email messaging, 46elks API: Cloud communication platform, Aalto social interface API: Social networking support service, abctext.com API: SMS text messaging service, AbleSMS API: SMS integration service, ABTXT API: SMS gateway service, Aerapay API: Mobile payments service, Africa's Talking API: African based SMS messaging service, Agendize Action API: Business conversion tools platform, Agendize Analytics API: Business conversion tools platform, Agendize Developers API: Business conversion tools platform, Agendize Platform API: Business conversion tools platform, AlertGrid API: Monitoring and alert service, AlertRocket API: Web based mobile messaging, Amazon SNS API: Application notification service, Anchor SMS Customer Management API: SMS customer management service, aql API: SMS solutions portal, ASPSMS API: SMS messaging service, AT&T MMS API: Multimedia messaging service, AT&T SMS API: Mobile SMS service, Avetio SMS API: SMS gateway service, Betwext Broadcast API: SMS messaging service, Betwext Remind API: SMS reminder service, BlueVia SMS API: Two-way SMS service, BT Web2C API: Communications services APIs, btexty API: Text messaging service, BuIkSMS API: Global SMS messaging, Bulletin Connect API: SMS Application Development Service, Bulletin Messenger API: SMS Service Provider, CallME Click-to-Call API: Phone and SMS messaging service, CampusCash Mobile API: Mobile Advertising Service, CDYNE SMS Notify API: SMS messaging service, Cellcom SmsGate API: Hebrew bulk SMS service, CellTrust API: SMS messaging, ChaCha API: SMS question and answer service, Clickatell API: SMS Messaging Services, Clickatell FTP API: SMS messaging services via FTP, Clickatell SMPP API: SMS messaging services via SMPP, Clickatell SMTP API: SMS messaging services via SMTP, Clickatell XML API: SMS messaging services, Clockwork SMS API: Bulk SMS messaging service, Club Texting API: Sending and Receiving SMS, Coinapult API: Send bitcoins via SMS or e-mail, Commzgate Gateway API: Online SMS text messaging service, Connection Software SMS API: Bulk SMS messaging service, Data24-7 API: SMS messaging/carrier/email/cnam lookup service, Deutsche Telekom Send SMS API: short messaging service, developergarden.com API: Telephony web services for voice and SMS, DialMyCalls API: Automatic calling and texting service, Dialogue Bulk SMS API: SMS messaging service, Distribute.IT API: SMS messaging service, Dotgo API: Web-based text messaging service, EmailBrain API: Email marketing campaign management service, eMarketeer API: Marketing campaign tracking service, Ericsson SMS Send and Receive API: SMS messaging service, Esendex API: Esendex Business SMS Text Messaging Service, Esendex Spain SMS API: Text messaging service, eWebvision Youranium API: SMS text messaging service, Expert Web Worx API: SMS messaging service, Express Text API: SMS marketing service, Ez Texting API: SMS Text Messaging Services, FanggleCast API: Message Sending and Tracking Service, fastDove API: SMS Management Service, FireText API: SMS marketing service, Fortumo Mobile Payments API: Mobile payment platform, FreebieSMS API: Bulk SMS messaging service, FreebieSMS Auto Dialer API: Send audio messages to phones, Frengo API: Mobile widgets and messaging platform, Fulcrum Mobile API: Text message marketing service, Geodrop API: SMS messaging service, Geosion mobile SMS API: Bulk SMS messaging service, GoMoText SMS Gateway API: SMS mobile marketing service, Grapevine SMS API: South African SMS/text message service, Group Texting API: SMS Messaging Service, Group2call API: SMS and voice messaging service, GSMA OneAPI MMS API: Mobile messaging services, HDmessaging API: Mobile messaging service, Heello API: Microblogging service, Hisign API: SMS text messaging service, Hoiio SMS API: Global SMS API, Hook Mobile API: U.S. and Canada multimedia mobile messaging service, HQSMS API: Bulk SMS messaging service, HummingBytes Q&A API: Communication service, Call API: Calling, VoIP, and messaging service, IIG Alerts API: Voice, SMS and Email messaging, Infobip API: Mobile messaging and solution service/Integrity Infotech Bulk SMS API: SMS gateway service, IntelePeer API: Telephony From the Cloud Service, Intouch API: Mobile group messaging, InVox API: Small and medium-sized business phone service, Its4sms API: SMS messaging service, iVisionMobile API: SMS gateway service, Jajah API: International Web Telephony Service, Kinross Group API: SMS messaging service, Knotice API: Digital direct marketing service, LeadsMob API: Mobile SMS and email marketing service, leadsNyou Email Marketing API: Email Marketing Service, Lemonstorm API: Online texting service, LOC-AID API: Mobile Location Service, Matrix SMS Gateway API: SMS messaging service, Mercury API: Mobile marketing service, MESSAGEmanager API: SMS and email message monitoring service, MessageMedia SMS API: SMS messaging service, messagingPeople API: Messaging Service, Mnatives API: Bulk SMS messaging service, Mobile Commons API: Mobile marketing campaign management service, Mobile Commons mData API: SMS messaging and response service, MobileStorm Communication API: Web-based marketing service, MobileTrend API: SMS Messaging Service, Mobilize Central API: SMS mobile marketing services, Mobivity API: SMS marketing messaging service, Mobiweb API: Bulk SMS messaging service, Mobyko API: Mobile phone syncing service, Modica Global Connect API: SMS gateway service, Mogreet API: Mobile marketing service, Monopond API: Fax, SMS and voice messaging services, Movil API: SMS messaging, Mozes API: SMS messaging service, Msg2send API: International SMS Service, Msgme API: Messaging and mobile marketing platform, MSGQ8 API: SMS messaging service for Kuwait, multimobil API: Swedish SMS/MMS and mobile payments service, Murrion Software Send SMS Text Message API: Text messaging service, MutluSMS API: SMS messaging service, My-Cool-SMS API: SMS messaging service, mysms API: Multi-device texting service, Net Oxygen SMS API: SMS service for business applications, Network Norway Content Provider API: Norwegian web content and SMS text messaging service, Nexmo Wholesale SMS API: Wholesale SMS API, Nextgen Mobile CardBoardFish API: SMS text messaging service, Nibbme API: SMS messaging service, NightLife Texting API: SMS text messaging service, Nimbuzz API: Mobile chat, text, and voice application, Northtext API: SMS text messaging and mobile marketing service, Opt It Mobile API: Mobile Marketing Application, Orange Personal Messages API: Mobile email messaging service, Orange SMS API: SMS Text Messaging Service, Oventus API: SMS messaging service, OzMedia API: Online marketing platform, Padpaw API: SMS text messaging services, Panacea Mobile Bulk SMS API: Bulk SMS messaging service, Panelesms Send API: Persian SMS advertisement service, Parlay X API: Suite of telephony services, Parseco API: Mobile SMS messaging platform, PGiConnect API: Email, messaging, and conferencing services, PingPing API: Online Payment Service, ProSMS API: SMS Messaging Service, ProTexting SMS API: SMS messaging service, Proxomo API: Social app development platform, PSWinCom Intouch API: SMS messaging service, PSWinCom SMS Gateway API: SMS gateway service, Pulse.to API: Group SMS/texting service, Push Channels API: Real-time push service, Ready to SMS API: Australian SMS texting service, Ringful API: Create rich voice and SMS mashups via simple RESTful API, Rocket Dispatch API: Mass messaging service, Rogers SMS API: SMS messaging service, RouteSMS API: SMS messaging service, RouteSMS Javascript API: SMS Messaging Service, RoutoMessaging SMS/MMS API: SMS messaging service, Sailthru API: Customized communication service, Sapo Messaging API: Text and voice messaging services, SeeMe SMS API: Bulk SMS messaging service, SendBulkSMS API: SMS service, Sendible API: Social Media Management Service, Sent.ly API: Text messaging service for Android phones, SFR MMS API: Mobile MMS service, SFR SMS API: Mobile SMS service, Shreeweb Bulk SMS API: Bulk SMS messaging service, Signal API: Interactive mobile and email marketing platform, Simple Texting API: Text message marketing service, SingTel Messaging API: Mobile network service, SKYPOST API: Italian fax service, SlideSMS API: SMS messaging service, SMS 55 API: SMS messaging service, SMS Action API: SMS messaging service, SMS Everywhere Messaging API: SMS messaging service, SMS Freedom API: Bulk text messaging service, SMS Global API: SMS messaging service, SMS GupShup API: SMS Group Message Service, smsBug API: SMS messaging services, SMSConCuba API: SMS messaging to Cuba, SMSCountry API: India/south Asia SMS messaging service, SMSFlight API: SMS messaging service, SMSgol API: SMS messaging service, SMSGuys API: South African bulk SMS/text message service, SMSified API: SMS messaging service, SMSimple API: Internet SMS service, SMSpoint API: Bulk SMS messaging service, SMStrade API: SMS messaging service, SMSWarehouse API: Bulk SMS gateway, smsways API: Greek mobile SMS service, SourceSMS API: Bulk text messaging service, Sprint API: SMS and MMS messaging service, State Of Text API: SMS messaging service, Strikelron Global SMS Pro API: SMS messaging services, Strikelron Mobile Email API: Mobile email messaging service, SUMOTEXT SMS Gateway API: SMS messaging service, SureVoIP API: VoIP service provider, Tagga SMS API: Ad support SMS message service, Tatango API: SMS messaging and marketing service, Taykt API: SMS messaging service, TeIAPI API: Telephony services for applications, Telefonica Open Movilforum API: SMS and MMS message service, Teleku API: Phone and SMS application service, Telenor SMS Alert API: Bulk SMS Alert Delivery Service, Telerivet API: SMS messaging service, TeliaSonera Messaging API: SMS messaging service, TeliaSonera SMS Poll API: Mobile poll creation service, TeliaSonera SMS Receive API: SMS messaging service, TellMyCell API: SMS Messaging Service, Text Marketer SMS Gateway API: SMS marketing service, Textanywhere API: SMS service, TextBelt API: Outgoing SMS service, Texteo API: SMS text messaging service, TextHub API: Text message marketing service, Textingit API: SMS Messaging services, Textingly API: Web-based text messaging service, Textlocal API: Mobile messaging service, TextMagic API: Bulk SMS messaging service, TextMarketer SMS API: SMS messaging service, TextMarks SMS API: SMS text messaging service, Textport API: Web-based SMS service, TMC SMS Gateway API: SMS gateway service, Tropo API: Communications API for voice, SMS and Instant Messaging, Trumpia API: Web-based marketing service, Twilio SMS API: SMS messaging service, Twilio Telegram API: Telegram hand delivery service, txtful API: Message enabling service, Txtlmpact API: SMS text messaging service, Txtlocal API: Group texting service, TxtMobster API: Mass text messaging service, txttools API: Messaging service, udefn API: SMS messaging service, Upside Wireless API: Text messaging service provider, Utterz API: Community site, Vazu API: SMS messaging service, Verizon Messaging API: Mobile messaging service, ViaNett API: SMS messaging service, Vodafone Betavine API: Mobile web services, Voovox SMS API: SMS messaging service, Wire2Air API: SMS messaging service, YLink API: SMS messaging and fax service, YouTXT API: SMS text messaging service, Zaypay API: Micropayments via SMS services, Zeep Mobile API: SMS text messaging service, Zhoutlt API: Local discovery service, ZNISMS DND Checker API: India Do Not Disturb registry checker, ZNISMS SMS API: Single and Bulk SMS service, Zooomr API: Photo and text message sharing service, and/or combinations thereof, without limitation.

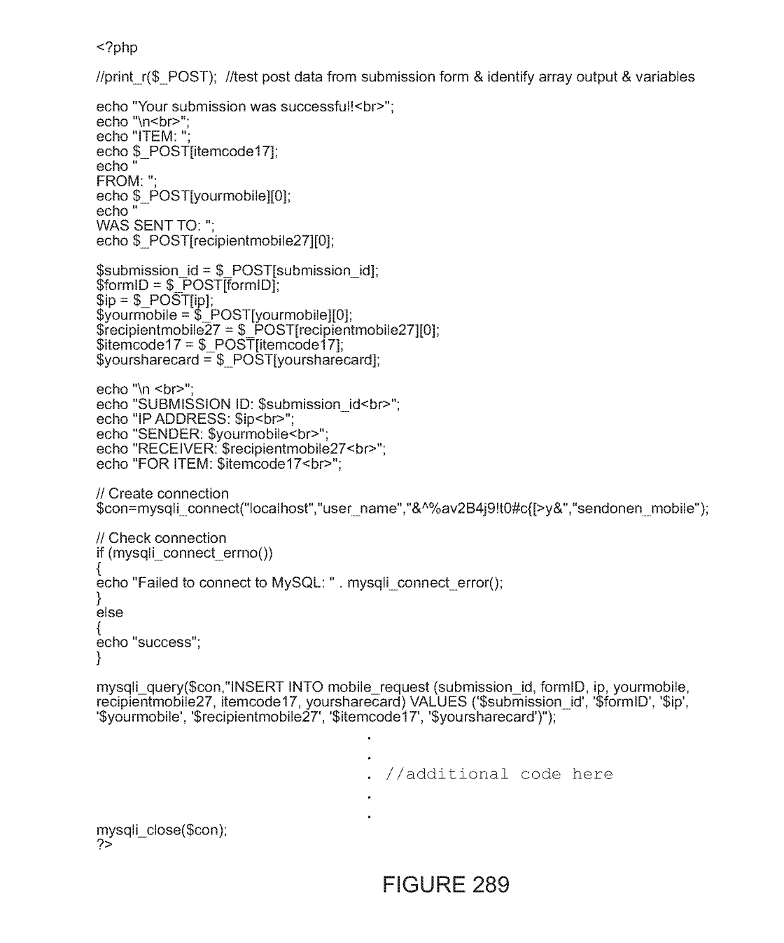

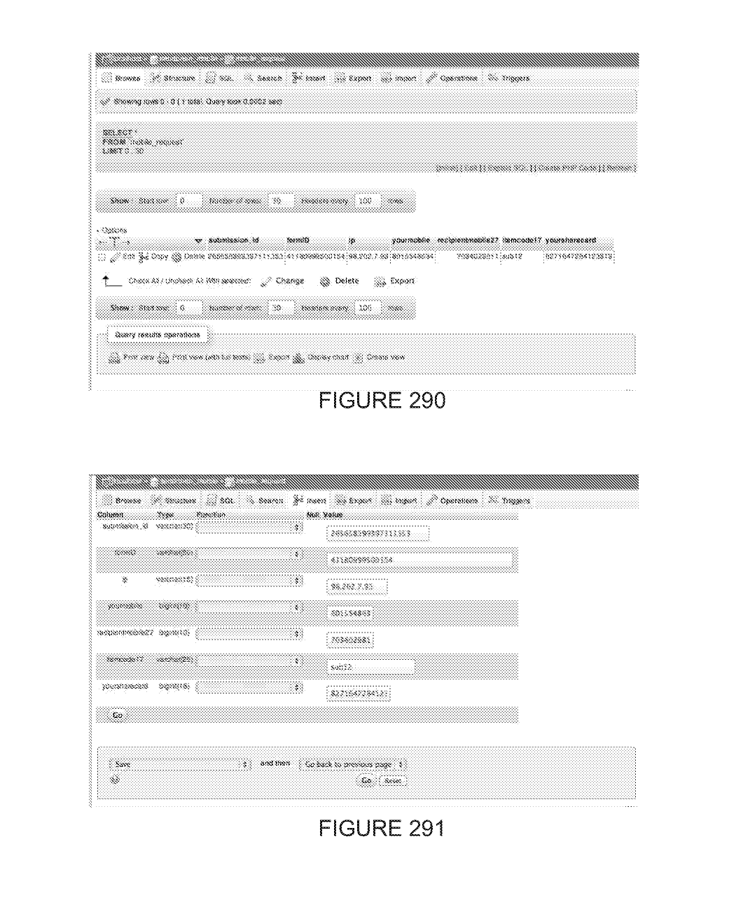

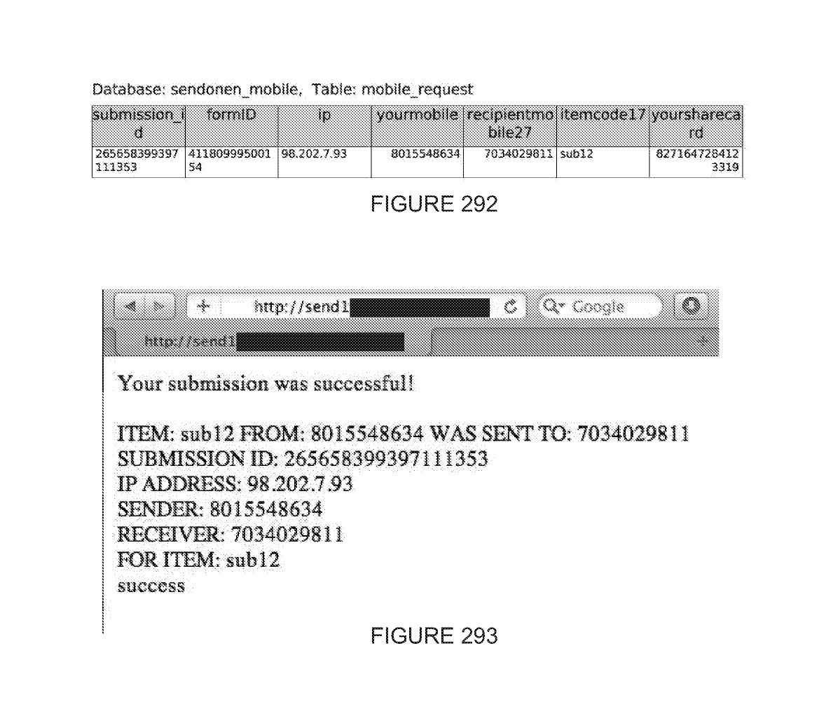

When submitted, POST data (e.g., in the form of an array, row, or other data structure) may contain variables with values that may be regurgitated to the user on a thank-you or confirmation page (e.g., as shown in FIG. 293), and this may serve to confirm an authenticated or otherwise successful transaction. While not shown, the confirmation page may comprise current balance information, options to send a personalized message, options to sign up for mobile marketing or email marketing programs, rewards programs, loyalty programs, or other promotions, without limitation. The variables and their respective values may be used in a server-side script, such as a PHP script (e.g., as shown in FIG. 289) to update, populate, add/delete, and manipulate database table information (e.g., as shown in FIGS. 290-292). One or more outputs 5 may be made by system components, for example, sending redemption information 64 and/or transaction information to a recipient and/or sender, via a number of different platforms, without limitation. Accordingly, even though the simple example described above and shown utilizes recipient phone number information and/or sender phone number information, any number of fields may be provided to allow input 4 regarding other forms and/or types electronic address information, as well as physical address information to be entered to perform various outputs 5, as a matter of convenience.

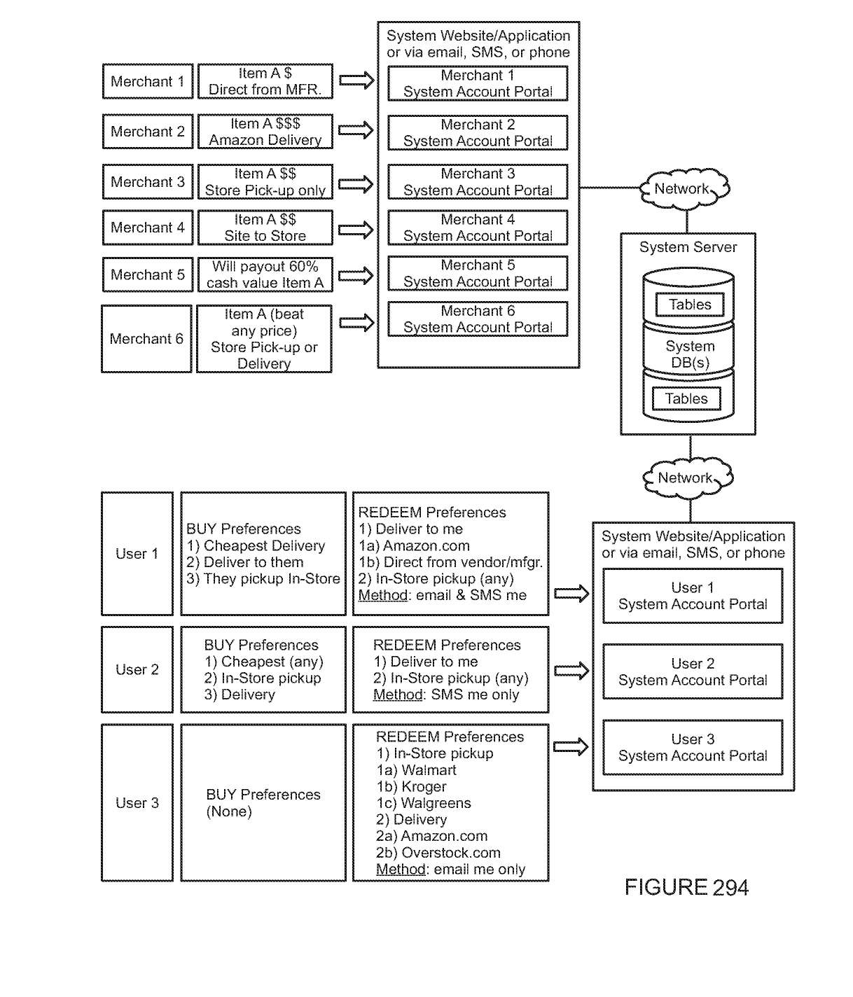

As suggested in non-limiting FIG. 294, both user and participating vendor/entities may, in some embodiments, access preferences 63 via a system account portal. In some embodiments, the portal(s) may be as simple as texting a command “preferences” to a system electronic address (e.g., a system number, short code, or email address) to access profile 130 information, and responding to various system prompts (e.g., “Reply with one or more of the following letters/numbers/characters representing the options you prefer, in the order of importance . . . ”), without limitation. In some embodiments, the prompts and/or follow up communications (e.g. follow-up electronic messages) may be made or sent via algorithms contained within system software 147 (for example, software on a system server 128 or on a mobile device 96 or computing device 95 communicating with a system database 147 via a network 118, without limitation). In some embodiments, a portal may comprise sending an email or fax communication to the system, which may be processed by a system component such as a customer service department, wherein the email or fax may contains preference information (e.g., a user agreement having appendices containing preferences as a portion of terms and conditions). For example, the email or fax communication may, without limitation, include text instructions, and/or a filled out system-provided form or contract which may be available from the system website 127. According to some embodiments, a portal may include a system phone number comprising a hotline which may have one or more or a series of interactive menus which can be navigated, selected, and interacted with using keypad entries or verbal command instructions (e.g., via automated attendant software), without limitation. In some embodiments, a hotline component of the system may be automated, powered by system software 147, or may comprise one or more humans affiliated with the system (e.g., a customer representative). In some preferred embodiments, the portal may be accessible via a system website 127 or application 147 component (such as a mobile application, “desktop” application, television application, connected vehicle application or the like), wherein user input 4 information can be communicated to system components 128, 129 via a network 118 (e.g., the Internet/Wi-Fi, satellite network, cellular network, and/or other network, without limitation).

Preferences 63 may include, without limitation, delivery preferences/priorities such as shipping preferences and address information, in-store pickup preferences, preferred participating vendor 65 preferences, and/or the like, as may be readily apparent from non-limiting FIG. 294. In this regard, the system may attempt to process transaction requests and/or uses of redemption information 64 in a prioritized manner, according to user preferences 63. In some embodiments, an algorithm component of system software 147 may be used to decide which criteria or criterion trumps other criteria or criterion, without limitation. For example, if a vendor 65 that might support redemption of an item in exchange for redemption information 64 is set up for “delivery only”, such criteria may trump a user preference 63 to pick up the item at a brick-and-mortar facility, without limitation. As another example, a sending user's 91 preference 93 to purchase items through the system using the cheapest possible method/vendor 65 may trump a recipient's 92 preference to redeem all items using a specific preferred method/vendor 65, without limitation. It is contemplated that the system may be as complex or as simple as necessary to provide a streamlined, platform that may provide the best user experiences, without limitation.

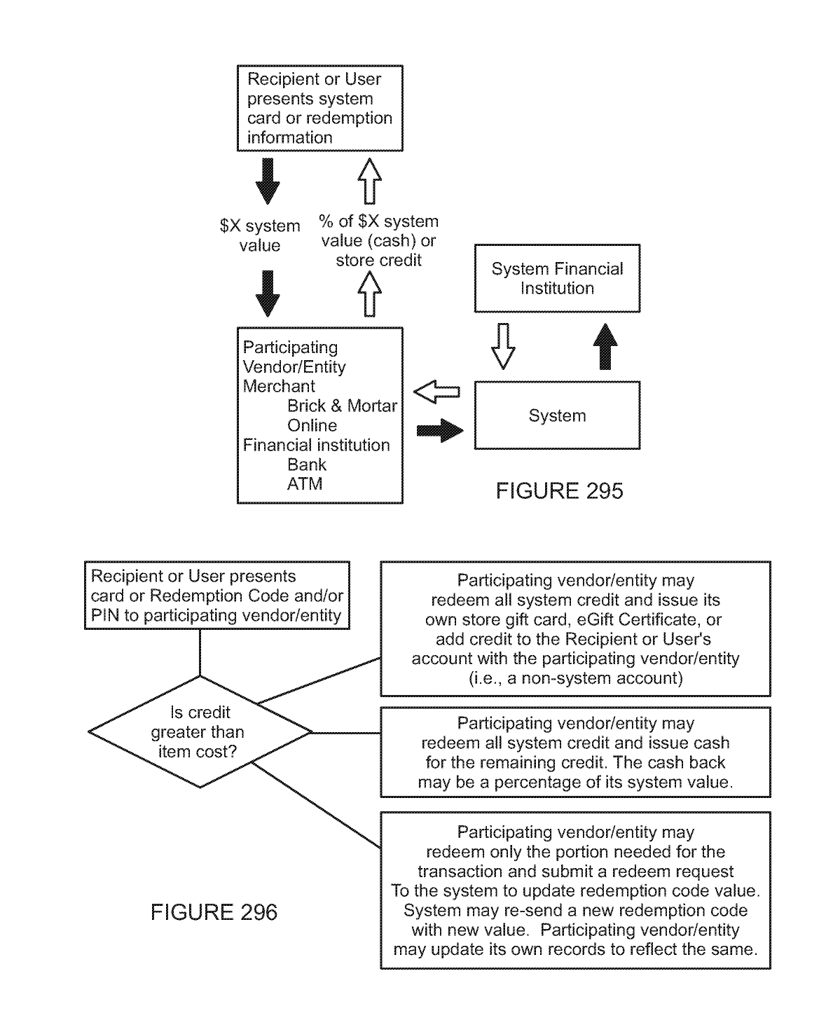

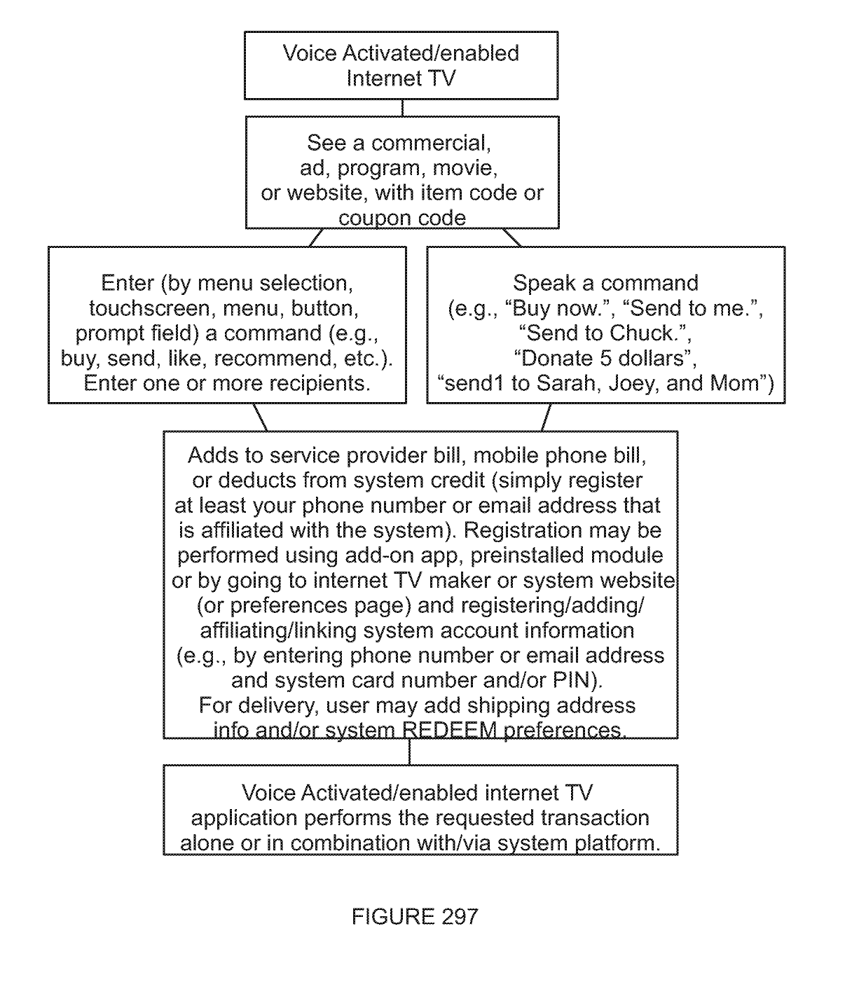

As suggested in non-limiting FIG. 295, in some embodiments, a user may “trade” or “cash out” system funds or credits (including system credit, redemptions for items, products, goods, or services, and/or the like, without limitation) for cash and/or other tangible monetary forms (e.g., payment data 10, store credit, store gift card, coupons, etc.), at the discretion of a participating entity 65, who may claim/redeem such traded system funds or credits from the system in exchange for one or more other monetary values (e.g., payment data 10). For example, in some embodiments, system components may reimburse a participating entity 65 and/or a user 91 for all or a percentage of the system credit value being traded. In some embodiments, a participating entity 65 may “re-gift”, sell, pawn, or trade redemption information 64, or otherwise utilize redemptions as collateral, for example, according to system user agreements, without limitation. Users with physical cards 19 (e.g., cards having a magnetic stripe, chip, a card number) and/or respective card PINs, may, in some embodiments, utilize kiosks 3 affiliated with participating financial institutions 163 (e.g., ATMs) to receive cash, checks, and/or electronic cash deposits, in exchange for their system credit, without limitation. In some embodiments, a participating financial institution 163 may take a percentile and/or charge a transaction fee, to complete the cash-out request; wherein the financial institution 163 may recover funds or credits from the system in exchange for financial institution-received system funds or credits (including redemption information 64). In some embodiments, for example, a user may insert the card 19, swipe the card, and/or present/touch the card adjacent appropriate reader or payment receiving means 100, 102, 110, 116 to extract the alternative form of funds. In some embodiments, a user interface 106 provided to a kiosk 3 may provide a number of audio and/or visual-based prompts as an output 5, and may present one or more options to select in response to the prompts. For example, a user 91 may select a menu option to trade and/or cash out system credit (e.g., “Press 4 to cash-out send1 ShareCard credit”), without limitation. In some embodiments, the user 91 may complete a system credit-for-cash transaction by entering one or more pieces of user data 8, such as account 48 information (e.g., information pertaining to any one or more of an electronic address (e.g., mobile device 96 number or email address), a system card number, a system card PIN, a system password, a one-time generated SMS PIN or pass code, and/or the like, without limitation) and selecting an amount to convert, transfer, and/or withdraw, without limitation. The kiosk software 147 may be integrated with system software to ensure adequate funds/credits to complete the transaction. It should be understood that such methods may be used with other types of kiosks 3 and terminals, including, but not limited to, vending machines, coin/change vending machines, currency converting stations, POS payment terminals, and/or the like, without limitation. Moreover, other inventive methods and concepts may be employed with such devices, without limitation.

As suggested in non-limiting FIG. 296, if a redemption code (e.g., for store credit or a number of items) is presented, and only a portion is used (e.g., $5.29 of $30 store credit is used, only some of the items of the redemption code are redeemed, and/or certain items associated with redemption information 64 are not available or otherwise sold out), then users may, in some embodiments, be compensated for a remaining portion of the total redemption information 64 value in a number of different ways. For example, in some embodiments, a participating entity 65 which may be providing redeemed items, products, goods, or services in exchange for redemption information 64 may issue a participating entity-specific gift card and/or participating entity-specific store credit for a remaining portion of the total redemption information 64, and the redemption information 64 (e.g., a redemption code) may be voided by system components 100, 147 (e.g., via the participating entity's P-O-S payment terminal 95), without limitation. In some embodiments, the participating entity 65 may provide cash or other payment data 10 to a user in an amount which is equivalent to a full value (e.g., a full value of system credit, a full value of a system-recognized value of a redemption code, a full value of an item, product, good, or service associated with redemption information 64, and/or the like), without limitation. In some embodiments, the participating entity 65 may provide cash or other payment data 10 to a user in an amount which is equivalent to a partial value (e.g., a partial value of system credit, a partial value of a system-recognized value of a redemption code, a partial value of an item, product, good, or service associated with redemption information 64, and/or the like), without limitation. In some embodiments, if one or more items, products, goods, or services are not redeemed, the participating entity may provide the redeeming user with cash back in the amount of a percentage (e.g., 75%) of the fair market or sale price value of the respective one or more items, products, goods, or services. Other higher or lower percentages are anticipated, without limitation. In some embodiments, for example, if a user has store credit remaining with an account associated with a participating entity 65 (e.g., store credit associated with a particular participating entity 65), the participating entity 65 may, in some instances, conversely provide system credit to the user in exchange for the store credit remaining with an account associated with a participating entity 65. The amount system credit given to a user during an exchange of the user's store credit for system credit may be a percentage of the store credit, without limitation (e.g., 100% or less than 100%). In this regard, a participating entity 65 may profit from or otherwise obtain a “convenience fee” for the exchange. In some embodiments, the system may credit a participating entity 65 for exchanged system credit received by a participating entity 65, from a user. The credit may be applied, for example, to the participating entity's system account balance. In some embodiments, a participating entity 65 may file a claim with the system in an amount equaling their full system account balance (or a portion thereof), in accordance with a system user/participant agreement; wherein the system may, upon receipt of the claim, provide reimbursement in cash or electronic funds transfer, and may respectively deduct the amount from the system account balance of the participating entity 65, without limitation.

In some non-limiting embodiments, a participating entity 65 may, upon receiving redemption information 64 from a redeeming user 92, send a “redeem” communication to the system via SMS, email, website, mobile application, or software installed or otherwise integrated with the participating entity's P-O-S payment terminal hardware and/or software. The “redeem” communication may include profile 130 information associated with the redeeming user 92 providing the respective redemption information 64, such as a remaining balance, a list of unredeemed items/products/goods/services, and/or electronic information, such as an electronic “cart” or “receipt” containing information regarding unredeemed items, without limitation. The system may generate new redemption information 64 (e.g., one or more new redemption codes and/or PINs) for a remaining/leftover amount or unredeemed items/products/goods/services, and may send the new redemption information 64 electronically to the redeeming user 92 presenting the original redemption information 64, for example, the system may send the new redemption information 64 to an electronic or physical address of the redeeming user according to the redeeming user's preferences 63 (e.g., via email, SMS, MMS, mobile messaging, social media, web-accessible profile 130 portal, voicemail, postal service, or the like), without limitation. According to some embodiments, the system's records 129 and/or the participating entity's records 137 may be updated to reflect the same, using system-integrated software 147, without limitation. Alternatively, the participating entity 65 may update their own records 137 to reflect the used redemption information 64 (e.g., one or more used redemption codes and/or associated PINs), may obtain information 8 from the redeeming user 92 (e.g., an electronic address, a phone number, email address, passphrase/pass code/password, ZIP code, and/or the like of the redeeming user 92), and/or may make a note of: which particular items/products/goods/services and/or amount(s) of store credit was actually redeemed, when it was redeemed, by who (employee), what transaction number, at which store location, which IP address or GUID was used during the transaction (if online), etc, without limitation. In this regard, the redeeming user 92 may, in some embodiments, utilize and re-utilize the same redemption information 64 (e.g., the same one or more redemption codes and/or PINs) at the same store/franchise or at a different store/franchise, at a later date to, for example, to utilize/redeem any remaining portions of funds and/or credits associated with the same redemption information 64. It is anticipated that various additional transactions could be performed to make parties whole when redemption information 64 (e.g., redemption codes) are partially used or left partially unused. In some embodiments, a user may “donate” or “gift” remaining portions of unused redemption funds, credits, or value to another user, friend, charity, company, or organization. Participating entities may optionally wish to “match” donations or donate a percentage thereof to the same or different charity. In some embodiments, unused portions of redemption information 64 may be exchanged for a gift card or store credit of the respective redeeming participating entity 65. In some embodiments, unused portions of redemption information 64 may be kept entirely by the respective redeeming participating entity 65, or may be kept entirely by the system, e.g., for re-use for other users/transactions, without limitation. In some embodiments, unused portions of redemption information 64 may be split between the system and the respective redeeming participating entity 65, without limitation. In embodiments where unused portions of redemption information 64 may be kept entirely by the respective redeeming participating entity 65, the system may credit the respective redeeming participating entity's system account balance, without limitation.

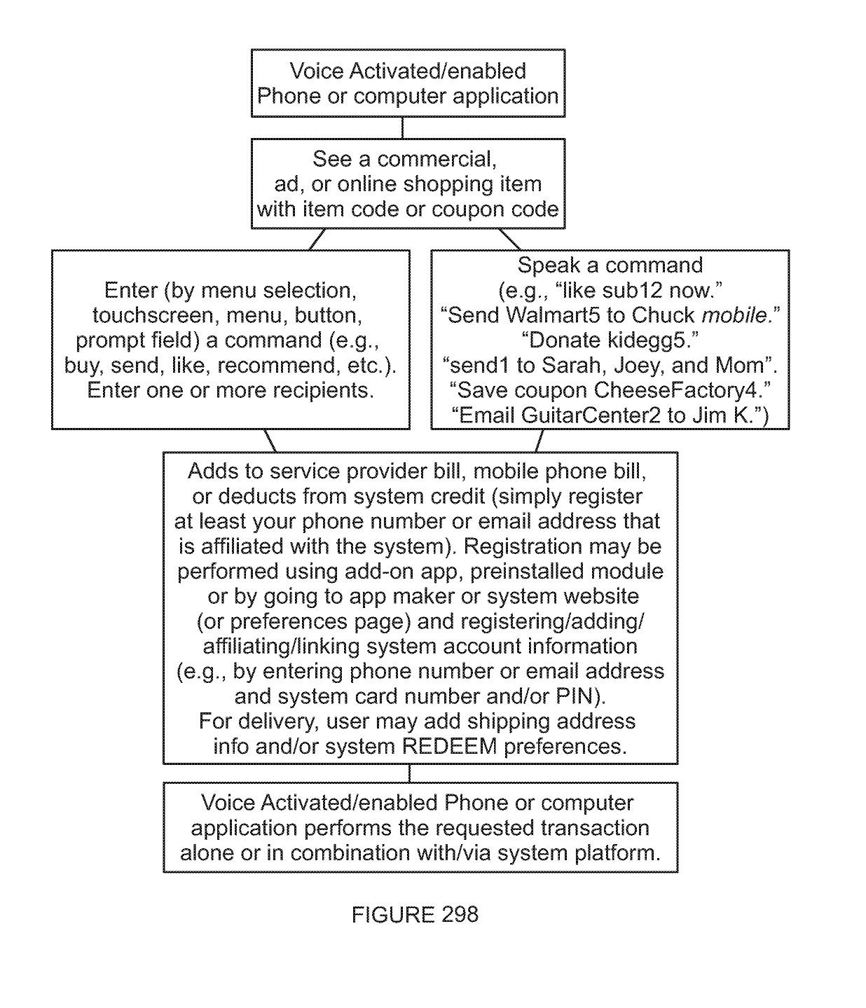

As suggested in non-limiting FIG. 298, the system, methods, apparatus, functions, transactions, steps, advantages, features, elements, and/or components thereof, described in this application and those applications to which this application claims priority to, may be integrated with “box-top” sets, such as internet TV, cable, satellite dish, or gaming modules which might be capable of displaying, emitting, and/or streaming media. Accordingly, in some embodiments, transactions may be requested by voice command and/or through manipulation of control mechanisms, such as user interfaces 105 provided to such sets (e.g., controller/remote controller/menu options, settings, options, preferences, etc.). In some non-limiting embodiments, gamers may transfer system credit to each other and/or collect pools which may be used to purchase items within a game. In some non-limiting embodiments, gamers may transfer system credit to an electronic address to collect funds which may be utilized as a “winner's pot”, of which may go to one or more winning gamers. In some non-limiting embodiments, home shoppers may see one or more items, products, goods, or services displayed on a monitor such as a television or projector screen via the box-top set (which may be connected to a fiber optic cable, coaxial cable, cable TV, over the air HD antenna, satellite, or the like), and may purchase, gift, like, post (e.g., to a linked social network), add to a wish list, add to a shopping list, and/or recommend the one or more items, products, goods, or services, for example, by interacting with and performing command functions using means for providing input 4 (e.g., interacting with a user interface 106 provided to the box-top set, interacting with a user interface 106 of a mobile device 96 (e.g., a mobile application 147 interface 106 or an SMS/MMS/mobile messaging platform interface 106), and/or interacting with a user interface 106 provided to a computing device 95), without limitation. Such interactions may comprise, without limitation, voice commands to one or more components of the system (including to one or more of the box-top set, the television, a controller, a remote controller, a mobile device 96, and/or a computing device 95 (e.g., gaming system, computer, laptop, tablet, etc.) which may be operably connected to, or communicating with each other, without limitation), controller input (e.g., pressing one or more remote controller buttons), mobile application 147 input, electronic communications to the system (e.g., via one or more electronic messages sent to the system containing instructions pertaining to a transaction request), and/or the like, without limitation.

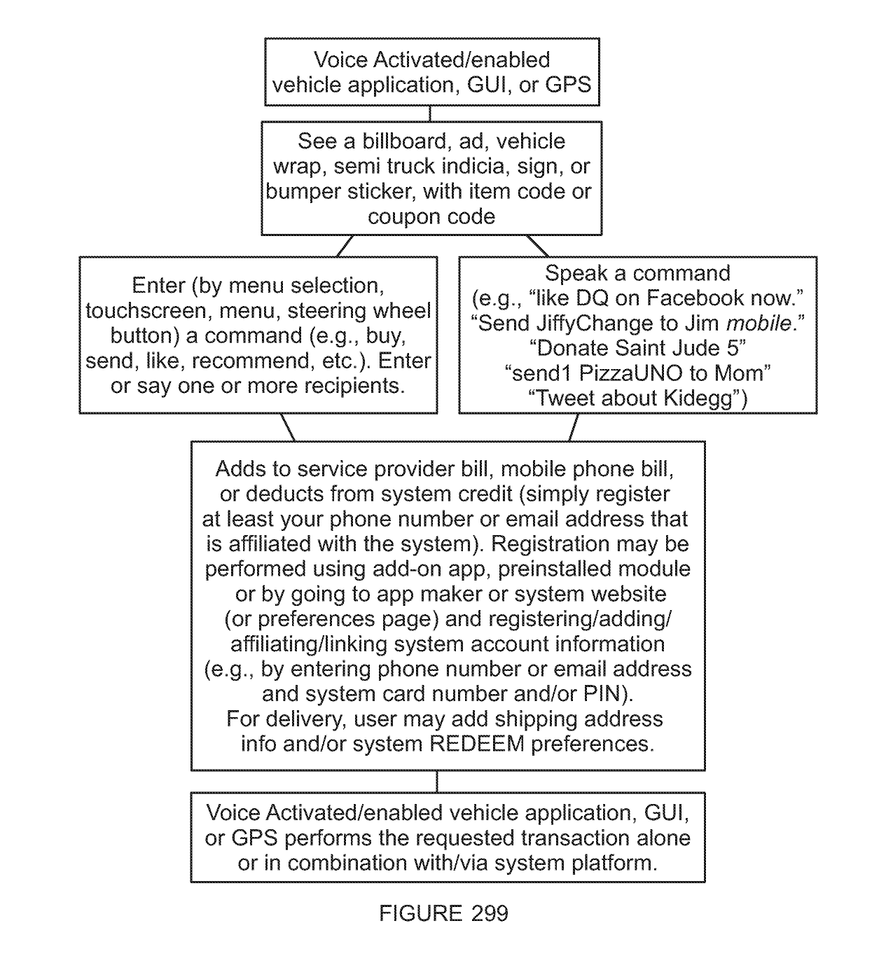

According to some embodiments, the system, methods, apparatus, functions, transactions, steps, advantages, features, elements, and/or components thereof, described in this application and those applications to which this application claims priority to, may be integrated with mobile devices 96 such as phones, tablets, wearable computers, semi-portable computing devices, or non-mobile computing devices 95, as well as various other types of articles (e.g., electronic/digital billboards, or non-electronic billboards or signs), without limitation. As suggested in non-limiting FIG. 299, similar methods, functions, transactions, steps, advantages, features, and/or components thereof, described in this application and those applications to which this application claims priority to, may be integrated with vehicle platforms or may be integrated with vehicle platforms which are integrated with mobile devices 96 (e.g., GPS units, navigational systems, “connected car” systems/computing devices 95, mobile phones, tablets, DVD players, MP3 players, Audio equipment, head units, onboard applications (e.g., On-Star/SIRI), combinations thereof, and/or the like), without limitation.

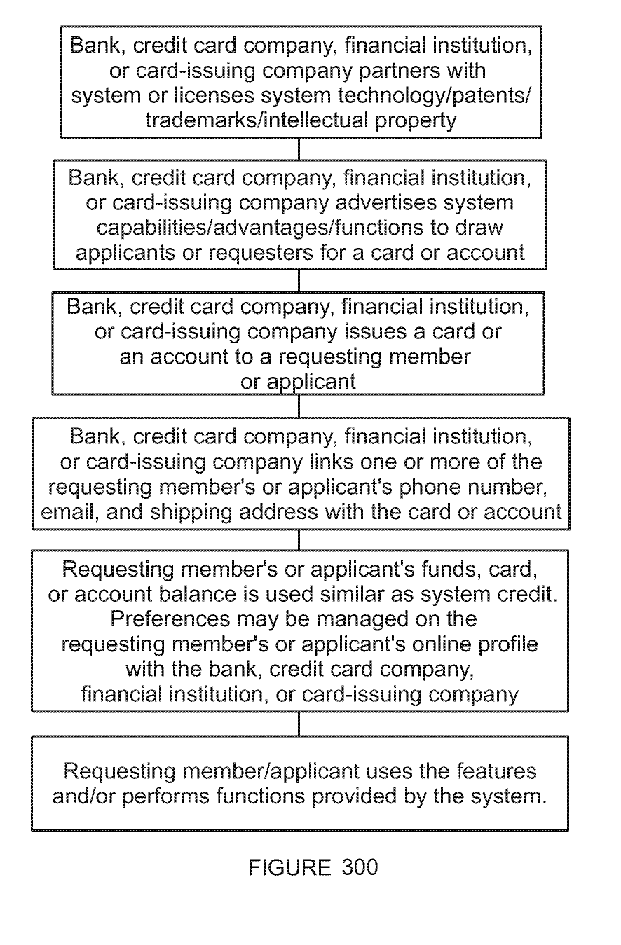

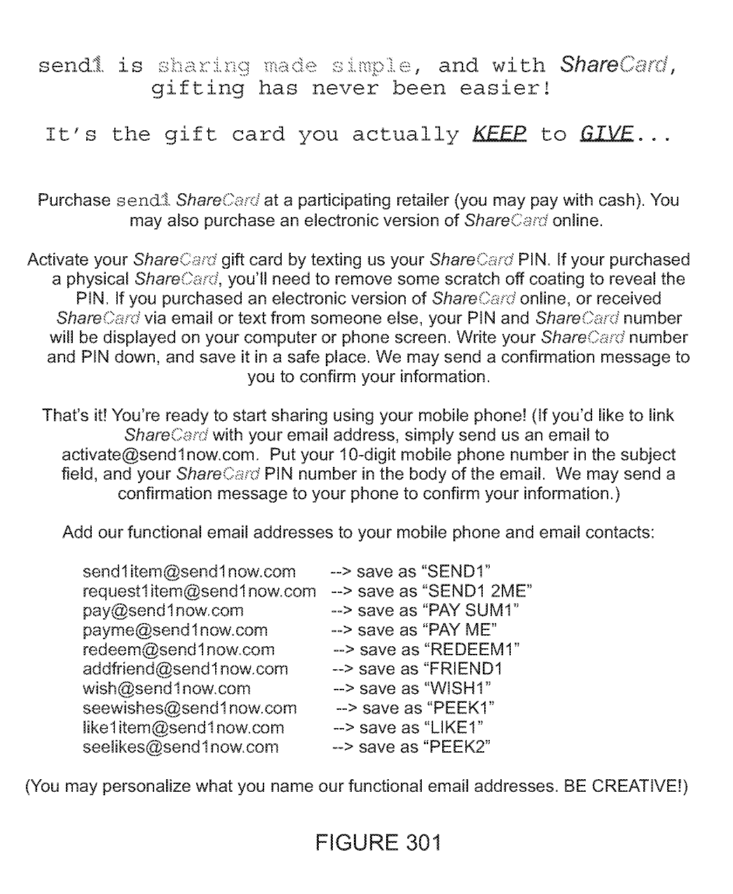

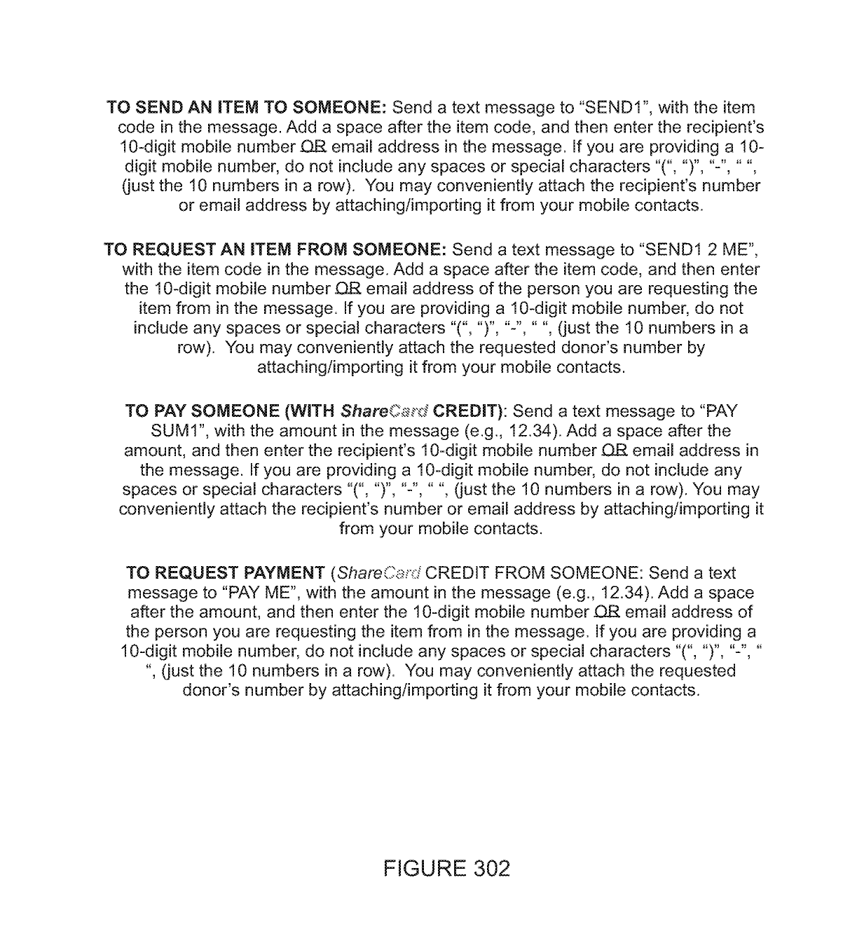

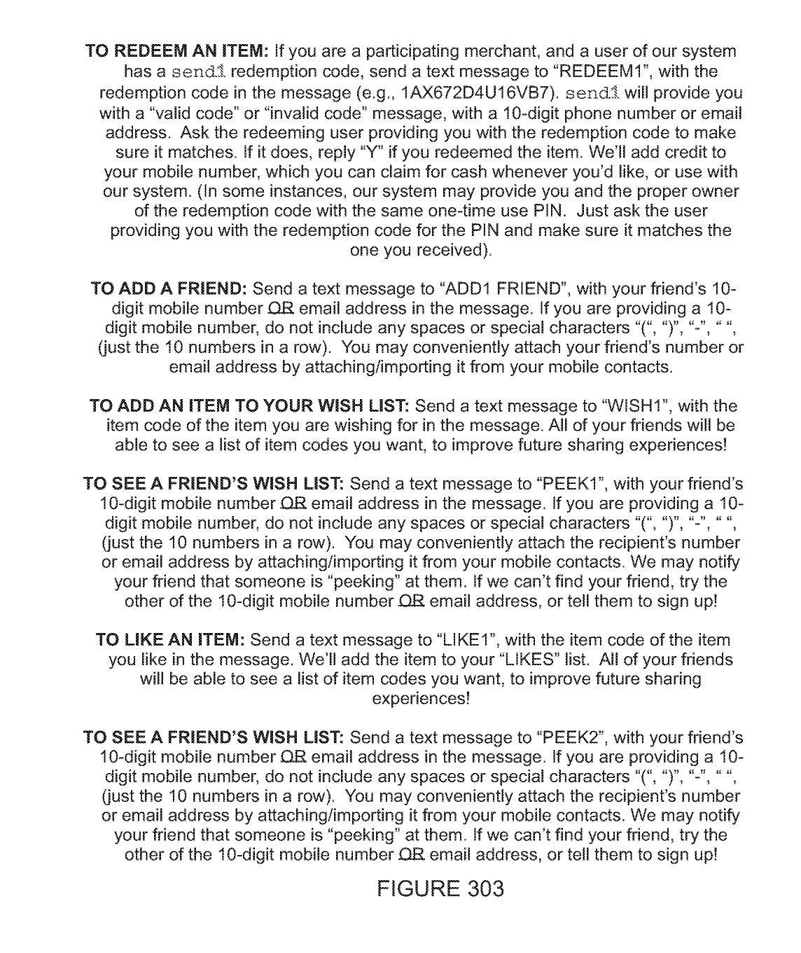

As suggested in non-limiting FIG. 300, the system, methods, apparatus, functions, transactions, steps, advantages, features, elements, and/or components thereof, described in this application and those applications to which this application claims priority to, may be practiced by and/or licensed for independent use by third parties such as financial institutions 163. In this regard, a third party may receive, deliver, manage, store, and/or process: payment data 10, funds, credits, redemption information 64, user inputs 4, system outputs 5, user data 8, purchase data 9, transactions and/or requests thereof, confirmations and/or requests thereof, and other system components (e.g., software 147, algorithms, etc.) on their own website, servers 122, platform(s), etc., without limitation. In some embodiments, a third party, such as a financial institution 163, may allow its members, or potential members (e.g., product or service applicants) or current users/customers to enjoy portions of, some, or all the benefits of the system and methods described, as well as portions of, some, or all the benefits of system components, without limitation.

Examples of computer code suggesting very basic working embodiments which have been successfully reduced to practice can be found in some of the aforementioned priority applications listed in the CROSS REFERENCE TO RELATED APPLICATIONS section of this application. It should be understood that any listings of computer code may be equally alternatively presented in a flow sheet diagram format, as necessary for better comprehension of the inventive methods and concepts, without limitation. However, for the sake of brevity, exemplary non-limiting code, as well as figures which might schematically represent algorithms and logical expressions contained within the exemplary non-limiting code has been intentionally omitted from this disclosure. The exemplary non-limiting code is hereby incorporated by reference in its entirety, without limitation. It is acknowledged that the exemplary non-limiting code which may have been used to actually reduce certain simplistic embodiments discussed herein to practice may not be terribly efficient and/or there may be some unnecessary redundancies; however, the inventor had no prior web design experience and had to learn to program the prototype server-side scripts using only available internet sources. Various working prototypes of a test website and various test platform(s) were created by the inventor from scratch, with no assistance. Accordingly, ordinarily skilled artisans within the relevant arts would readily appreciate numerous ways to improve functionality, scalability, reliability, performance, and/or efficiency of the disclosed technology. Those having an ordinary skill in the art would readily appreciate how simple embodiments of the platform can be, how to derive alternative best modes and/or conceivable commercial embodiments (e.g., for robust security and/or improved privacy), and/or how easy it might be to integrate (e.g., via API's, add-ons, “apps”, software, etc.) the system with other third-party platforms and/or databases, without limitation. Moreover, persons having an ordinary skill in the art would readily appreciate obvious manners and ways of integrating other platforms and/or databases with embodiments of the system through a network 118. For example, “communications made to/from the system” may be performed in any conceivable way, so long as the results of the communications, operative functions associated with said communications, and/or foreseeable outputs 5 are consistent with the spirit of this disclosure. Examples are herein provided solely to better understand some of the inventive concepts and functions, and/or to demonstrate both actual and constructive reductions to practice, without limitation.

According to some non-limiting embodiments, a *.php file or equivalent script may receive incoming web form-based user submissions to the system (e.g., via POST data), may populate/manipulate a system database 129, and/or may provide one or more system communications to one or more sending users and/or one or more recipient users, without limitation. According to some non-limiting embodiments, a *.php file or equivalent script may receive incoming SMS/MMS/mobile messaging application-based user submissions to the system (e.g., via POST data), may populate/manipulate a system database 129, and/or may provide one or more system communications to one or more sending users and/or one or more recipient users, without limitation. According to some non-limiting embodiments, a *.php file or equivalent script may receive incoming email-based user submissions to the system (e.g., via POST data), may populate/manipulate a system database 129, and/or may provide one or more system communications to one or more sending users and/or one or more recipient users, without limitation. According to some non-limiting embodiments, a *.php file or equivalent script may receive incoming phone call-based user submissions to the system (e.g., via POST data), may populate/manipulate a system database 129, and/or may provide one or more system communications to one or more sending users and/or one or more recipient users, without limitation. According to some non-limiting embodiments, a *.php file or equivalent script may receive incoming social media-based user submissions to the system (e.g., via POST data), may populate/manipulate a system database 129, and/or may provide one or more system communications to one or more sending users and/or one or more recipient users, without limitation. According to some non-limiting embodiments, a *.php file or equivalent script may receive incoming web-based user submissions to the system (e.g., via POST data), may populate/manipulate a system database 129, and/or may provide one or more system communications to one or more sending users and/or one or more recipient users, without limitation; wherein web-based user submissions may comprise inputs 4 made using image data 6, audio data 7, voice commands with a user interface 106, tactile engagements with a user interface 106, or the like. In some embodiments, web-based user submissions may be performed using an application (e.g., television add-on or app, browser 131 add-on or app, mobile-application, connected car add-on or app, kiosk application, and/or the like, without limitation). According to some embodiments, the application used to make web-based user submissions may be installed on any suitably-configured mobile device 96, computing device 95, or device/machine comprising a suitably-configured mobile device 96 and/or computing device 95, without limitation. It should be appreciated that code used in a system-integrated application 147 and/or used with various system components could easily be modified in algorithmic expressions or logical expressions to allow the delivery and/or receipt of funds or credits to multiple recipients, without limitation, for example, by allowing a user to enter multiple recipient electronic addresses (e.g., multiple phone numbers, or an email address and a phone number, or a social media screen name and a phone number), without limitation. It should also be appreciated that code used in a system-integrated application 147 and/or used with various system components may be integrated with third party (i.e., non-system) databases, API's, software, websites, and/or platforms, without limitation.

It should also be appreciated that code used in a system-integrated application 147 and/or used with various system components could readily be modified to allow users to enter one or more recipient electronic addresses (e.g., one or more mobile numbers) in the body of an email or text message, wherein when such an incoming email or text message is received, the body of the email or text message may be parsed by system software 147 to extract the one or more recipient electronic addresses placed into the body of the email or text message by the requesting user, and wherein the parsed one or more recipient electronic addresses may be utilized, for example, in conjunction with system software 147 and a system-integrated database 129, 135, 137, 138, to complete a transaction, without limitation. According to some embodiments, transactions may be completed in a similar fashion (e.g., wherein a sending user may get their system account or system-linked account debited, recipient and transactional information (e.g., user data 8, purchase data 9, payment data 10, redemption data 65, and/or the like, may be stored in a system-integrated database 129, 135, 137, 138, and communications may be sent to one or more recipients and/or the sending user), without limitation.

In some embodiments, redemption data 64 associated with one or more pre-purchased and/or partially pre-purchased redemption options may be redeemed by a redeeming entity, which may comprise, without limitation, a participating entity 65, such as a vendor or a merchant. The redeeming entity may send a communication with redemption information 64 (e.g., one or more redemption codes) to the system. In some embodiments, the recipient user 92 providing the redemption information 64 may provide inconsequential personal information, such as an area code or system component-prompted portion of data (e.g., “enter the last 4 numbers of your card 19 PIN followed by the last four digits of your phone number”), and the redeeming entity may add the inconsequential personal information to a portion of the redemption information 64 (e.g., to the beginning or the end of a relevant redemption code) prior to sending the redemption information 64 to the system in an electronic data communication (e.g., a text-based electronic message communication, without limitation). The system may optionally check to make sure that the redemption information 64 provided by the redeeming entity to the system contains inconsequential personal information, and may check to see if the inconsequential personal information matches with information contained within a system database 129 (e.g., look up redemption information 64 in a database 129 and check to see if information 8 associated with user(s) affiliated with the redemption information 64 comprises the inconsequential personal information), without limitation. In some embodiments, a bona-fide recipient user(s) which may be in the process of providing the redemption information to use/redeem the redemption information 64 may be electronically sent or otherwise provided with (e.g., via a system application 147), one or more claim codes which may be given to the redeeming entity to complete the transaction. The one or more claim codes may be generated by the system, via system components, and may, in some embodiments, be withheld from all users 65, 91, 92 until time of redemption.

In some embodiments, the one or more claim codes may comprise image data 6 and/or audio data 7. In some embodiments, the one or more claim codes may comprise machine readable indicia. In some embodiments, the one or more claim codes may be provided in the same machine-readable indicia (e.g., within the same scannable 1-dimensional or 2-dimensional bar code). In some embodiments, the one or more claim codes may be coded and/or encrypted, and/or configured to be decoded and/or decrypted. In some embodiments, the one or more claim codes may comprise image data 6, such as a string of characters which may comprise numeric, alpha-numeric, case-sensitive, special characters, symbols, combinations thereof, and/or the like, without limitation. In some embodiments, the one or more claim codes may be delivered within an electronic communication to a recipient user 92, for example, via the recipient user's mobile device 96. In some embodiments, the one or more claim codes may be delivered within an electronic communication to a redeeming entity, without limitation. In instances where the user receives the one or more claim codes, the redeeming entity may provide the respective merchandise, item(s), good(s), product(s), and/or service(s) to the recipient user 92, and, in exchange for the respective merchandise, item(s), good(s), product(s), and/or service(s), the recipient user 92 may provide the one or more claim codes to the redeeming entity. The redeeming entity may, in some embodiments, provide both the redemption information 64 and the one or more claim codes (or information pertaining thereto including portions of the one or more claim codes) to the system immediately, on a predetermined periodic basis, or as desired. Upon receipt of the same, the system may check its database 129 via software components 147 to ensure that the used/redeemed/voided redemption information and the one or more claim codes (or information pertaining thereto) match, and may provide payment to the redeeming entity in system credit, cash, check, money order, credit card payment, wire, financial service provided (e.g., PayPal), or other conceivable form of payment data 10, without limitation. Depending on user-system agreements, payable funds or credits may, in some embodiments, be delivered to a corporate entity of the redeeming entity, wherein the redeeming entity may provide a reimbursement claim to the corporate entity, and the corporate entity may receive the reimbursement claim from the redeeming entity, without limitation. To prevent accidental loss or use, in some embodiments, as a system safeguard component, users may be prevented (e.g., prevented by system software 147) from accidentally using/redeeming/voiding their system-delivered received redemption information 64 (e.g., such as redemption codes they received from the system) when using their own devices 95, 96, and/or from their own electronic addresses. For example, a command sent to the system (e.g., “void 7j92klsl4104dkpe”) by a recipient user 92, using a system component or platform may be rejected if the redemption information (e.g., “7j92klsl4104dkpe”), is owned by the recipient user 92; wherein a participating entity 65 or other user 91 may, in some instances, be able to perform a similar command to use/redeem/void the same redemption information (e.g., “7j92klsl4104dkpe”) using their own system component(s) from their own electronic address(es), without limitation.

In some embodiments, redemption information 64 (e.g., one or more redemption codes and/or redemption image data 6, such as machine-readable indicia) received by a recipient user 92 may optionally be “re-gifted” one or more times (e.g., to another user 91, and then to yet another user), between one or more users, with or without penalty for each re-gift transaction request made to the system. Similarly, functions like recommending, wishing, liking, and/or the like, which may be requested via transaction requests made to the system, may come with or without cost to the requesting user's system account balance or system-integrated third party balance, without limitation.

According to some non-limiting embodiments, phone-based communication methods, as well as social platform-based communications may be utilized to perform the types of transactions through the system described herein and/or discussed in the co-pending related patent applications listed above, without limitation. For example, according to some embodiments, information received by the system (e.g., in the nature of a keypad entry during a phone call to the system, or in the nature of text (e.g., system-recognized syntax) within a Twitter-based “Tweet” electronic communication containing a special system-recognized hashtag/item code, which is addressed to a system Twitter handle/electronic address, or otherwise contains a system Twitter handle/electronic address or system “vanity” address or recognizable tag) may be strategically parsed, stored, and used to access and/or manipulate system-integrated database 129, 135, 137, 138 information, without limitation. For example, tables within a system-integrated database existing in the “cloud”, and/or tables stored on a system server 128 or third party server 122, 125, 136 (e.g., a host or social media platform 93), may be accessed, created, and/or adjusted as necessary to debit funds from one or more users, and credit funds or redemption information 64 for one or more other users (e.g., intended recipients listed in the electronic communication made to the system). Account creation may be instantaneous and/or automatic without the recipient's acknowledgement, request, or authority. For example, in some preferred embodiments, account creation for unrecognized recipient electronic address information or other user data 8 provided as an input 4 may be performed on behalf of a user making a transaction request to the system, without limitation (this may be appreciated from the code listings found in the aforementioned related co-pending applications listed herein). Recipients may, in some embodiments, be provided with the option to decline a transaction request, an option to not receive redemption information 64, an option to decline participation in the system, and/or an option to request removal of a created account (e.g., a “do not call” response request), without limitation. In some embodiments, such options may be provided to a recipient, and the system may wait for confirmation input 4 from the recipient, before database 122, 135, 137, 138 information is adjusted and/or finalized (e.g., before a sending user's account is debited, and/or before the recipient receives redemption information 64 such as system-based funds or credits or other payment data 10 associated with redemption information 64), without limitation.

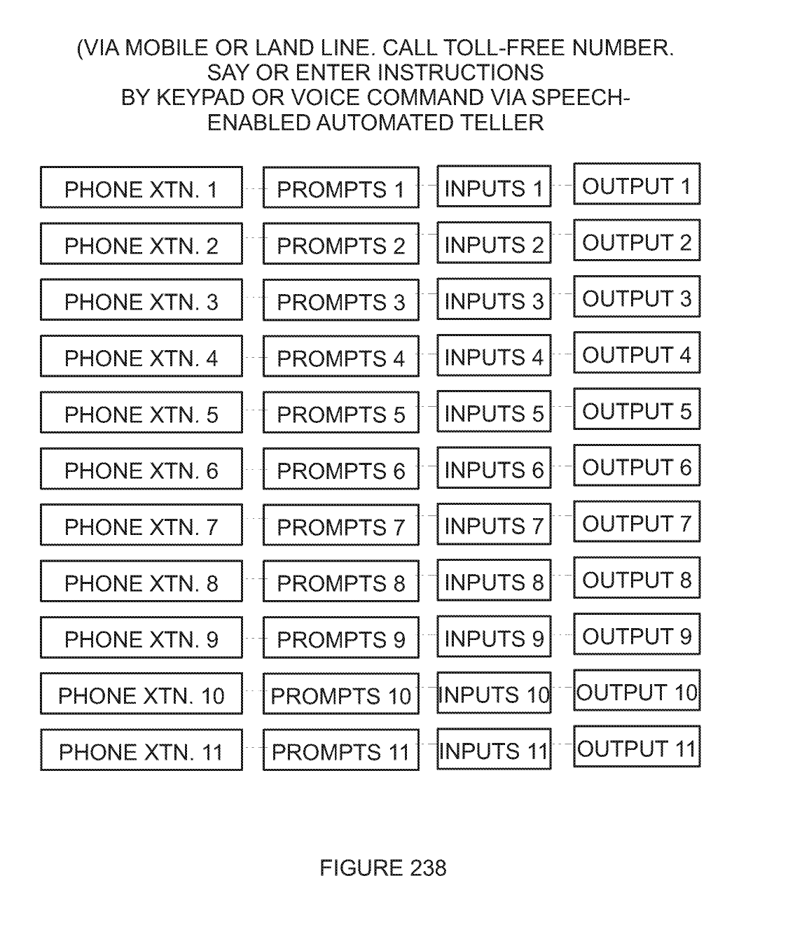

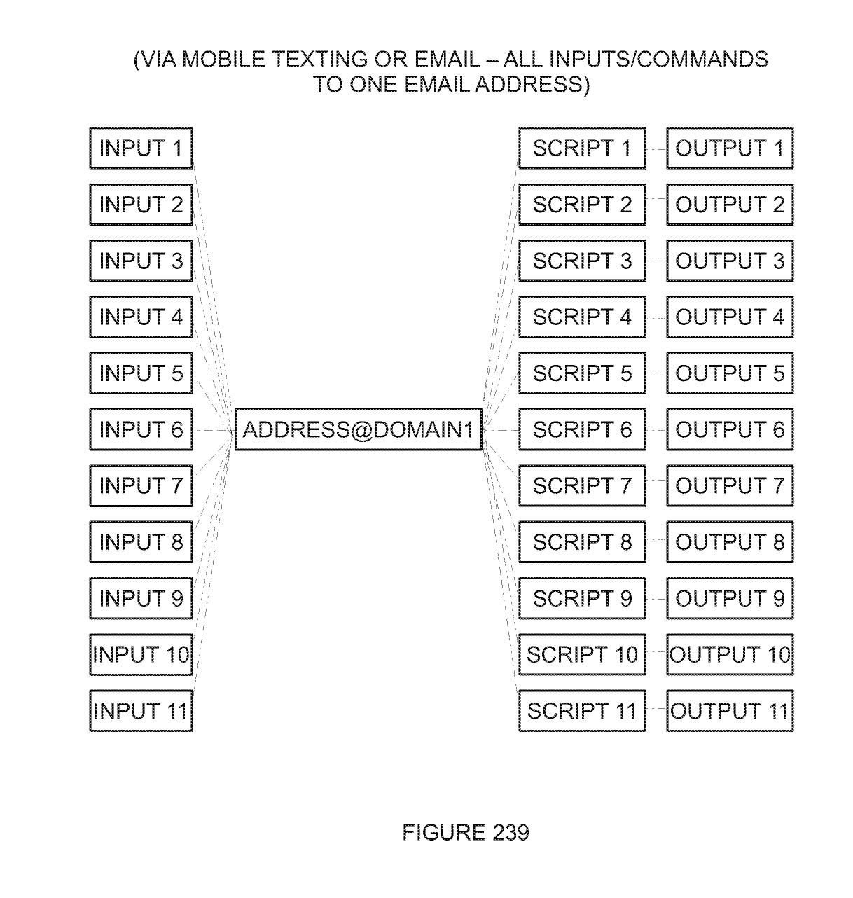

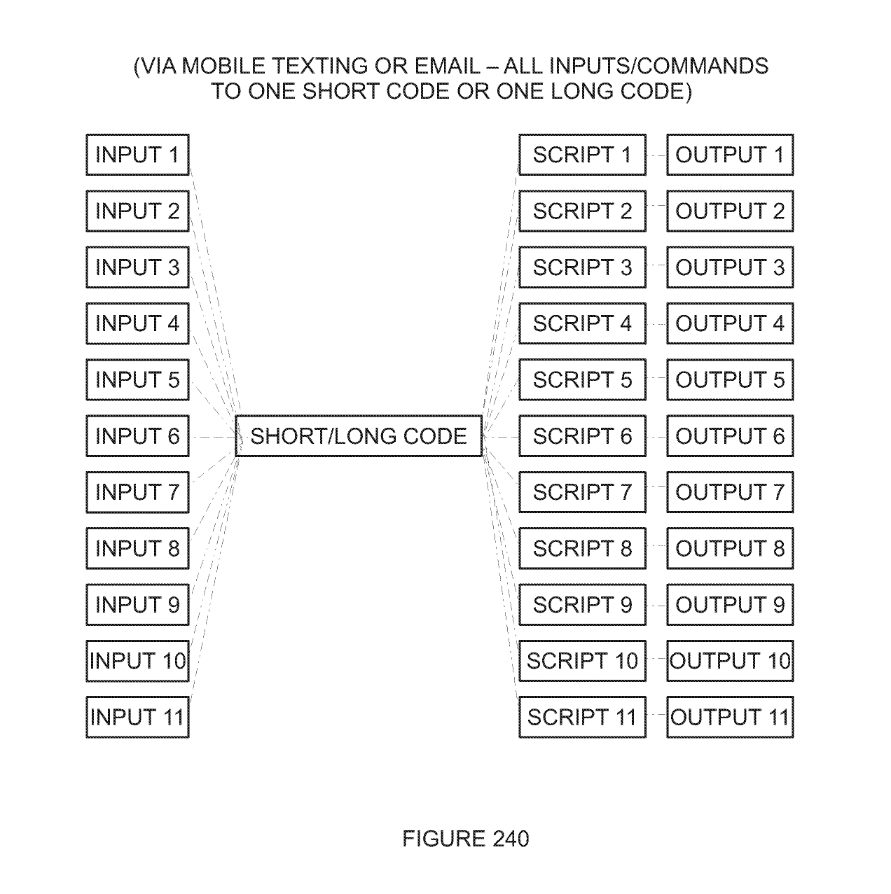

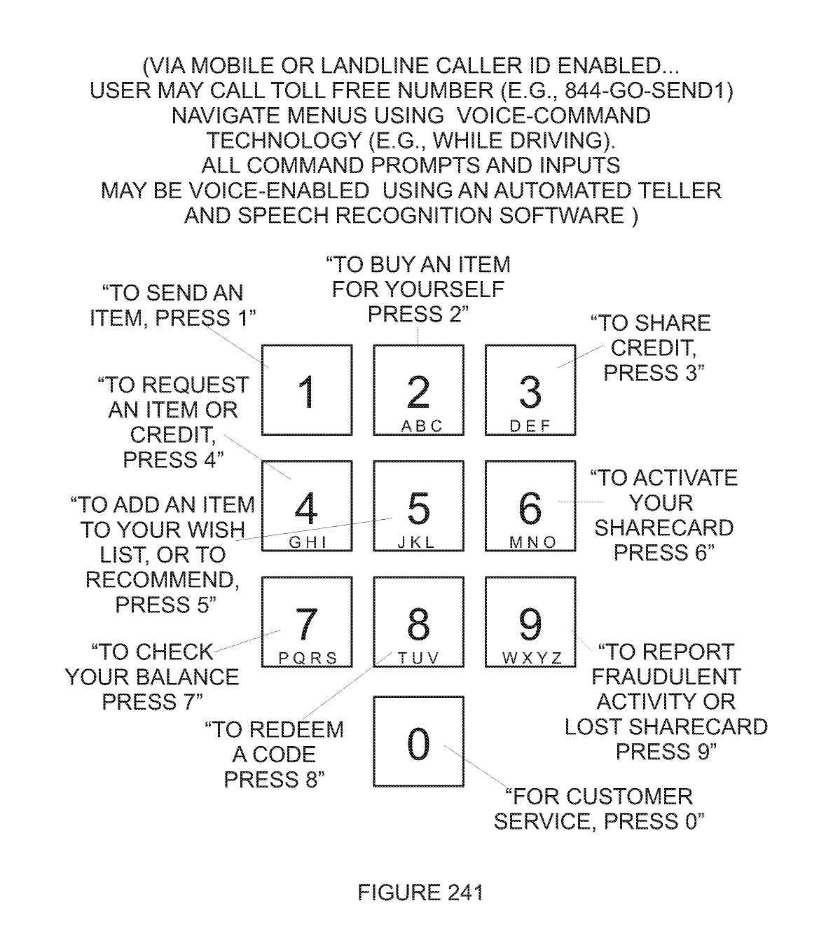

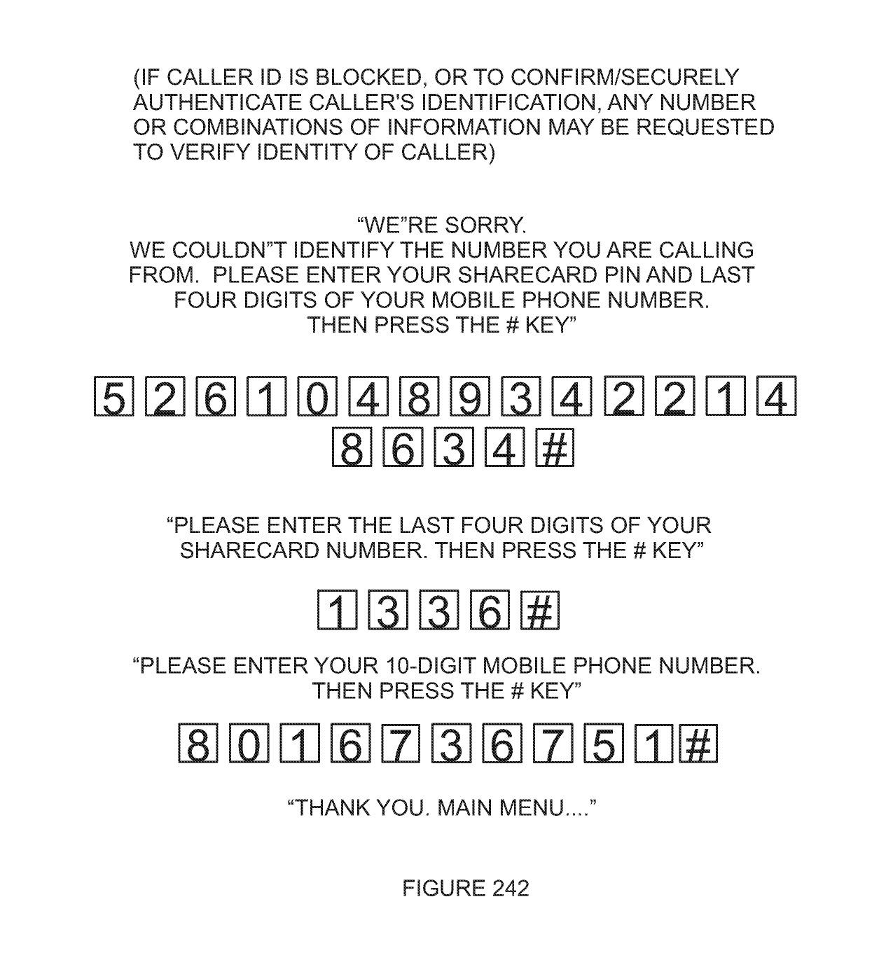

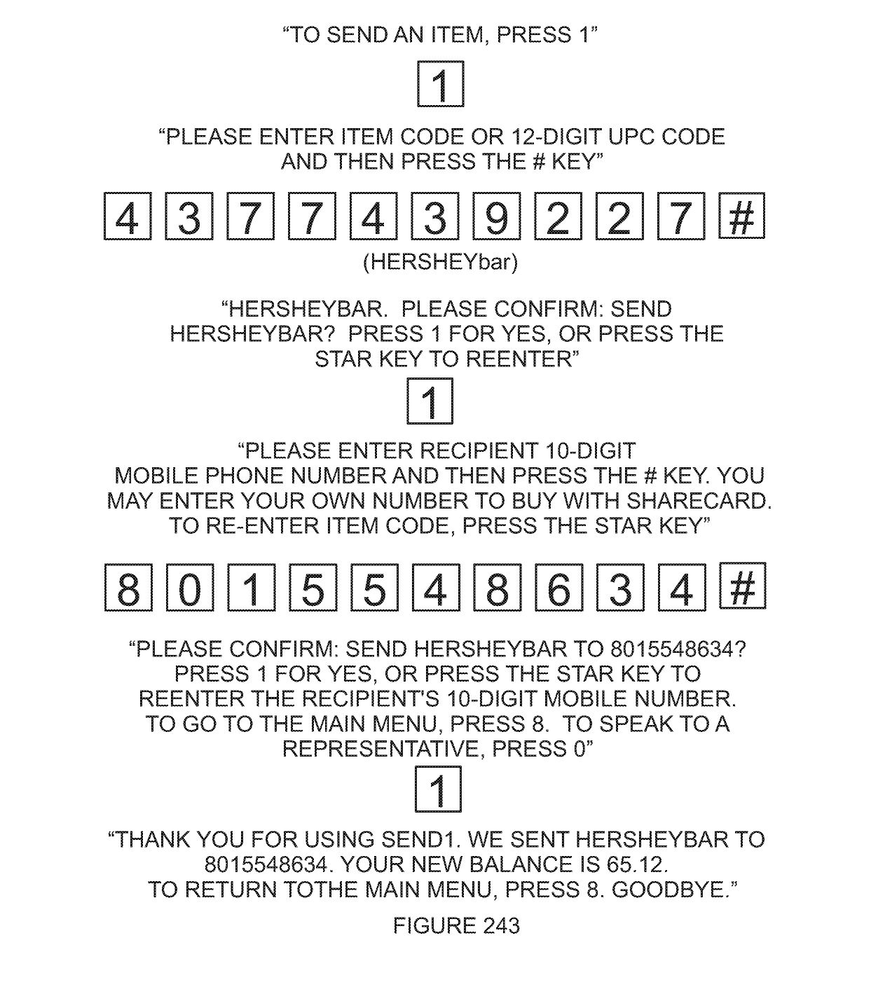

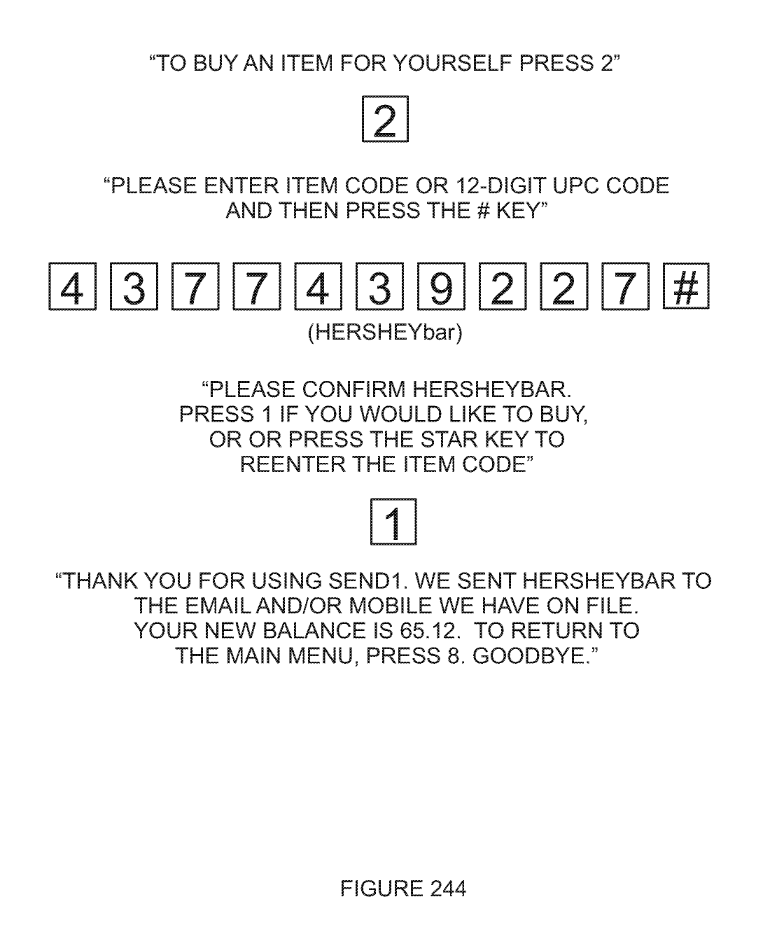

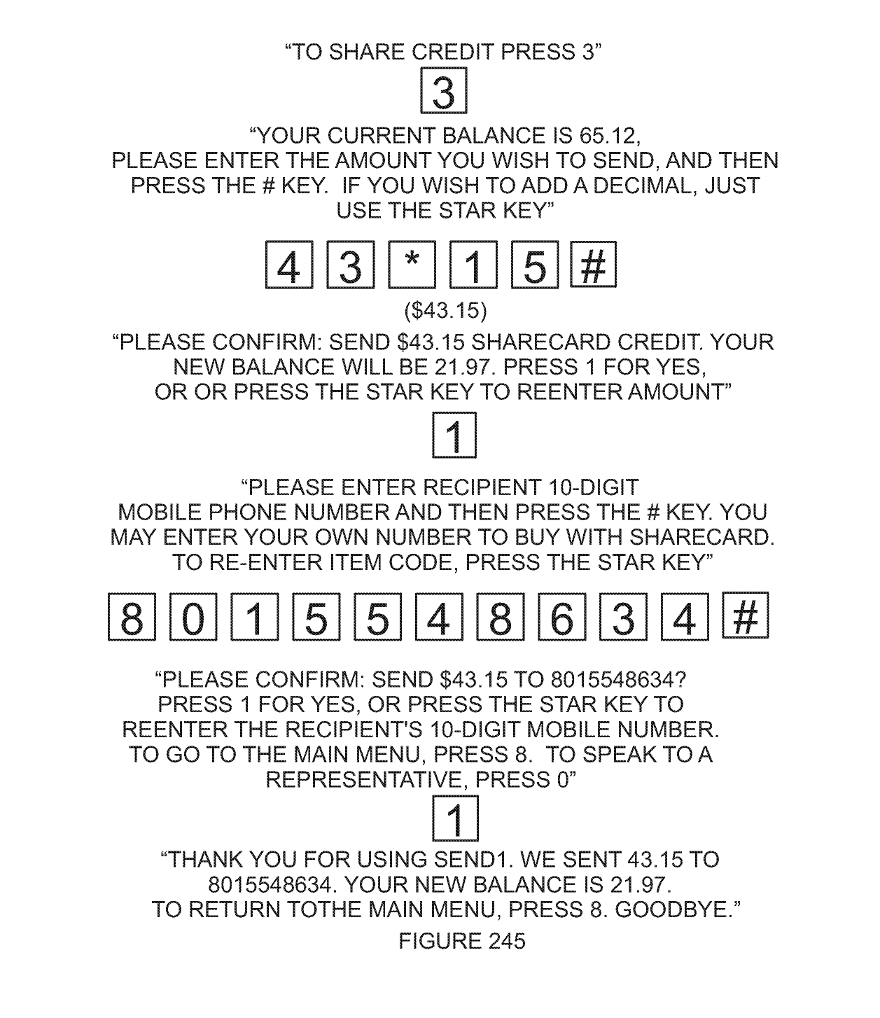

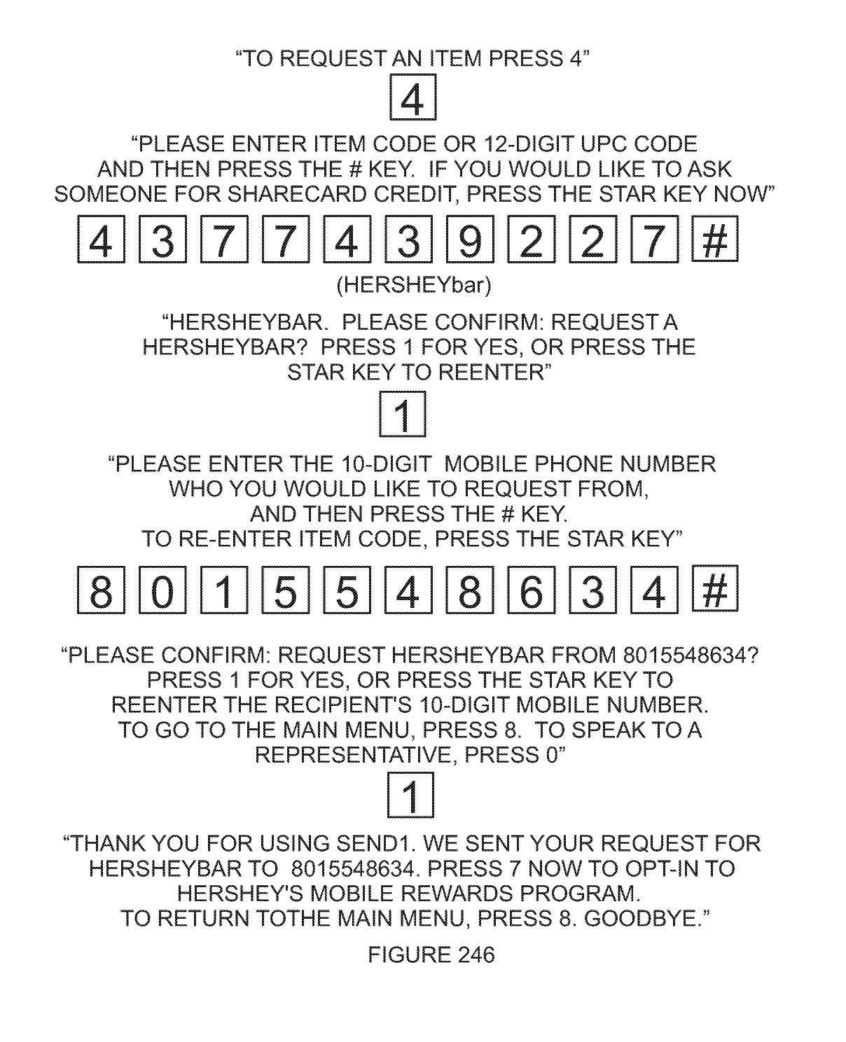

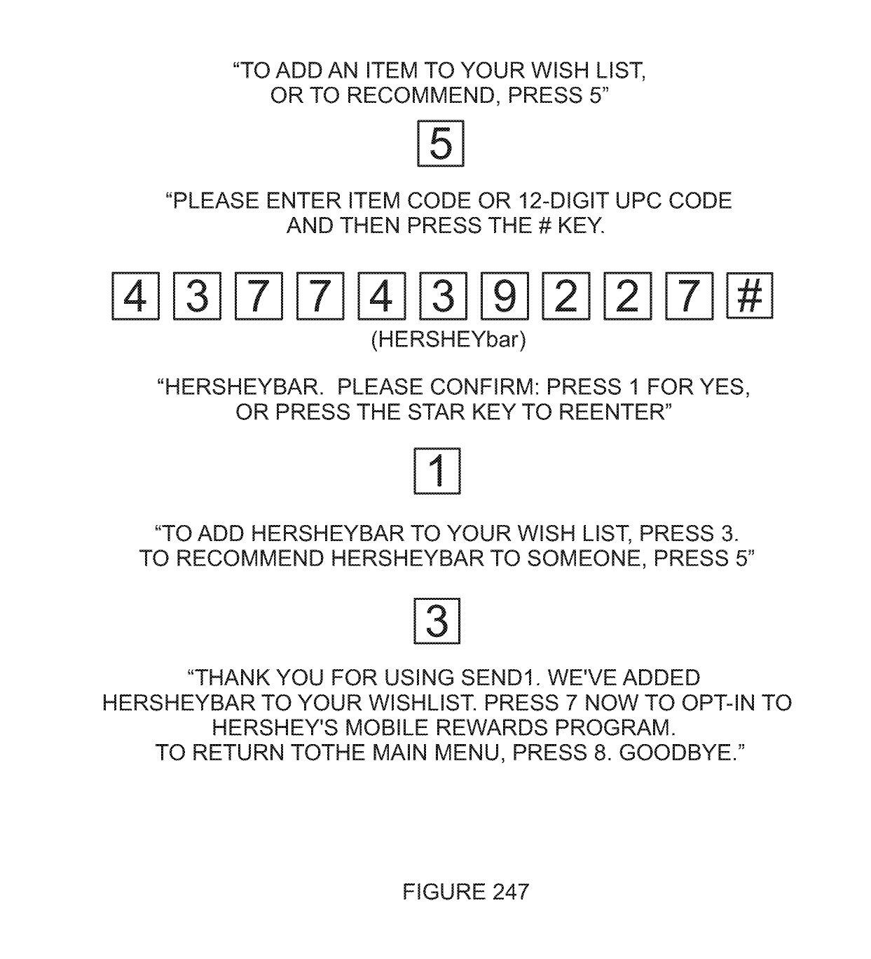

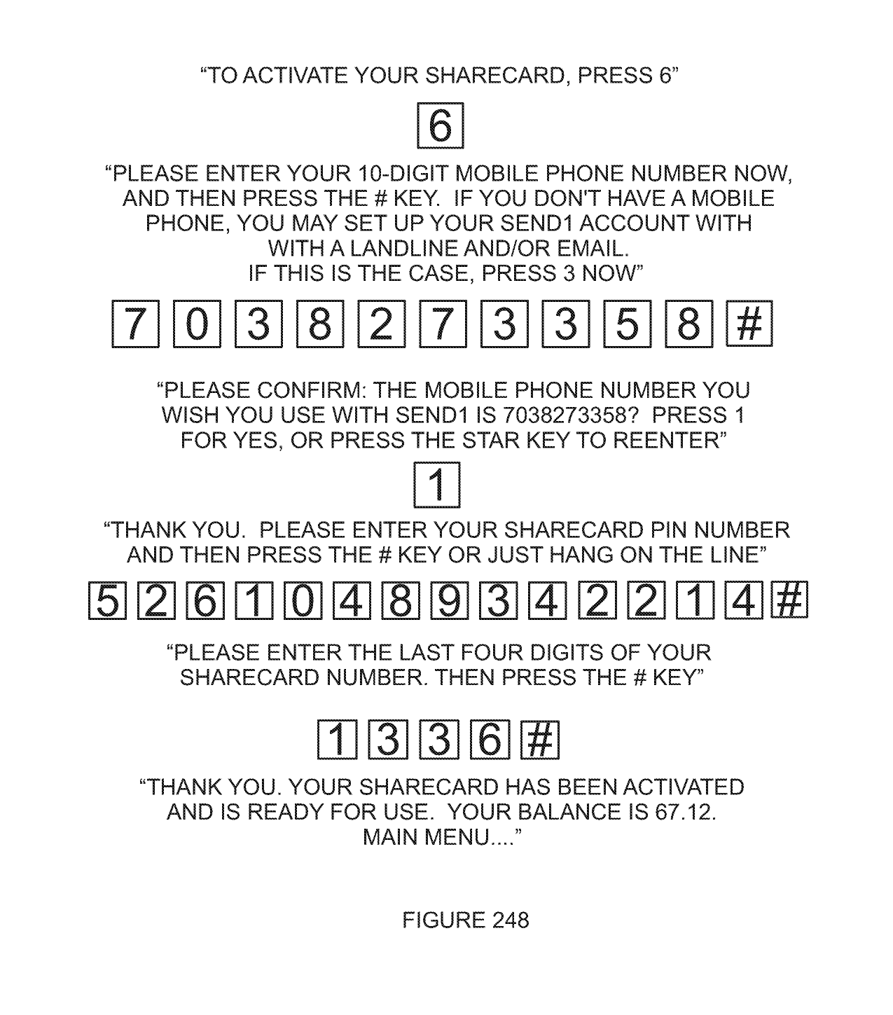

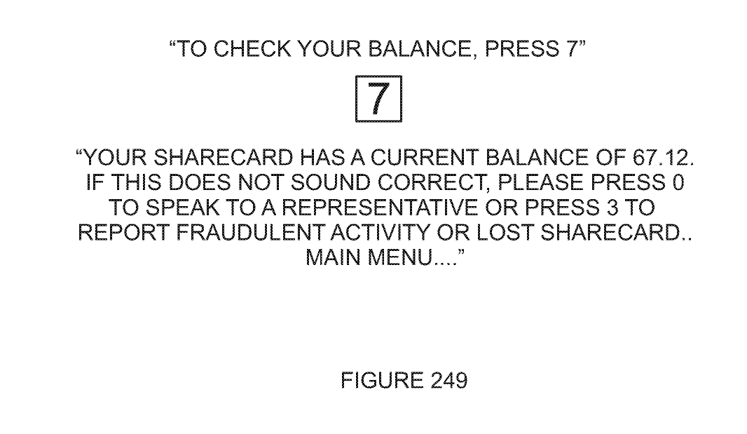

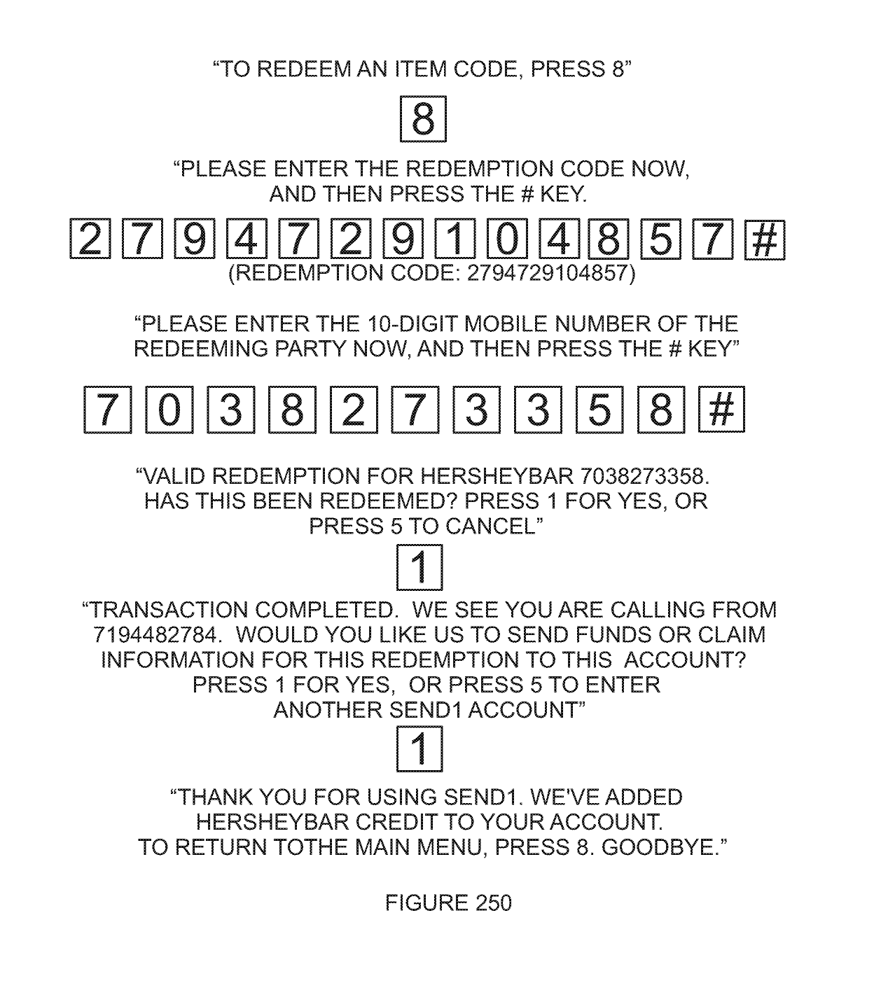

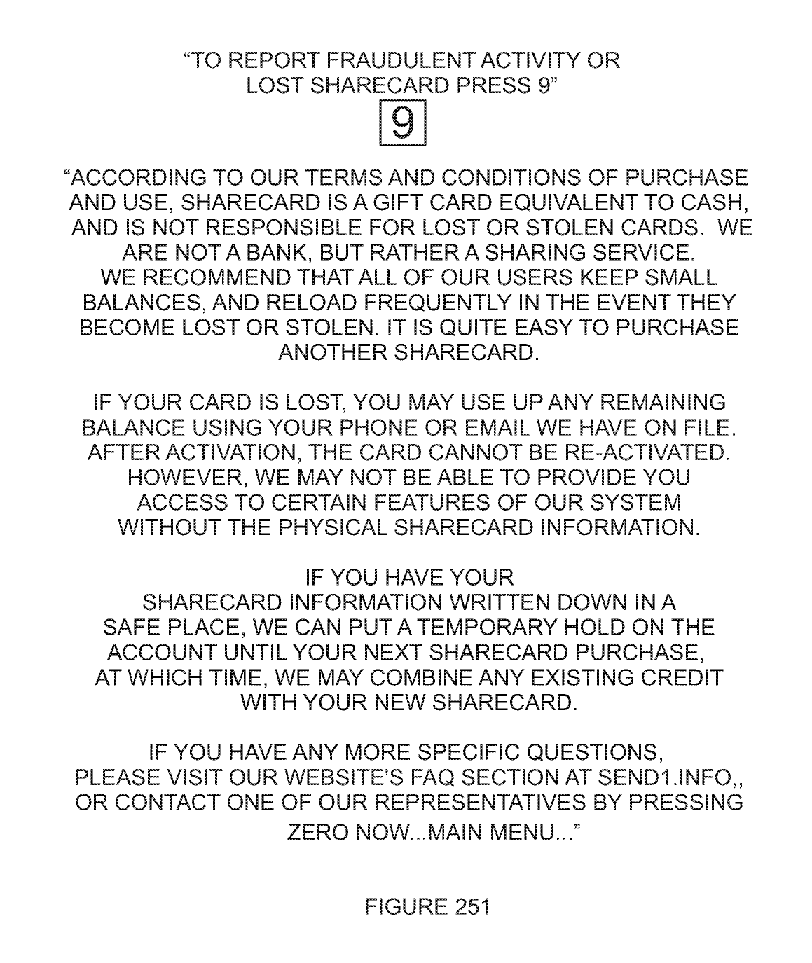

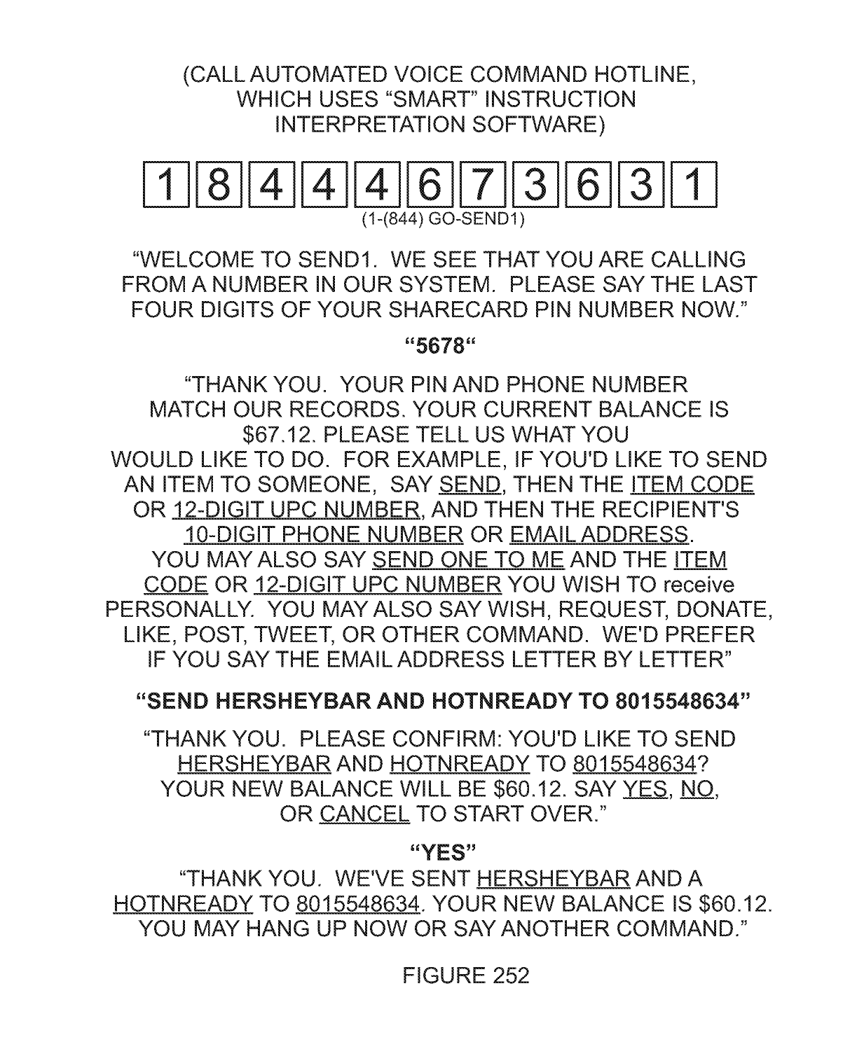

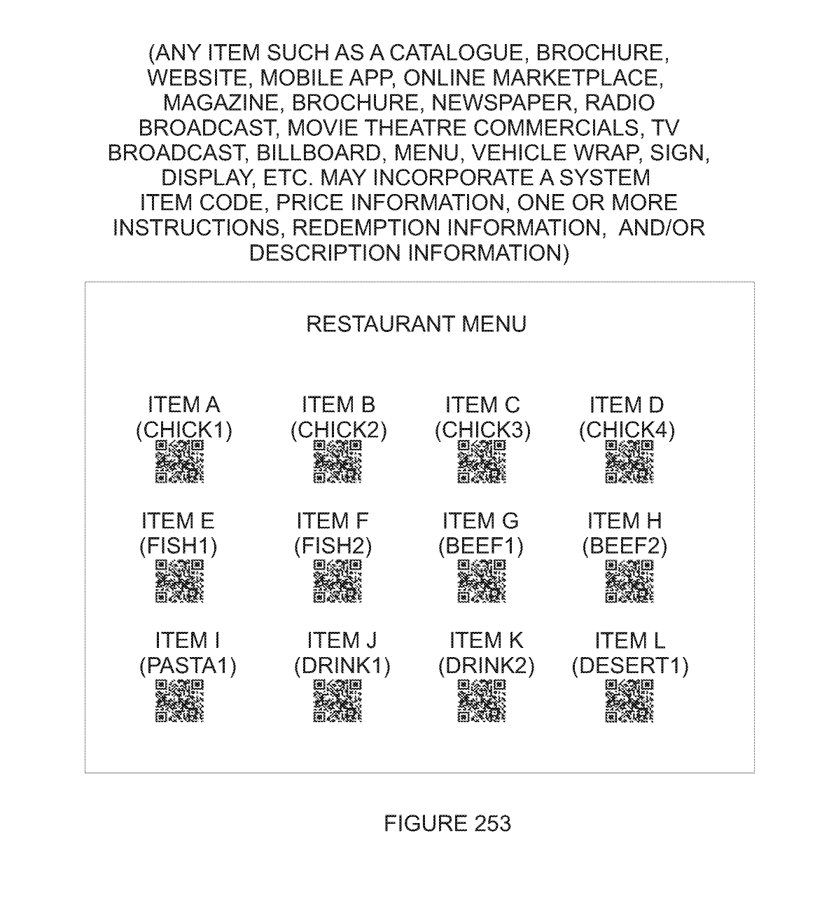

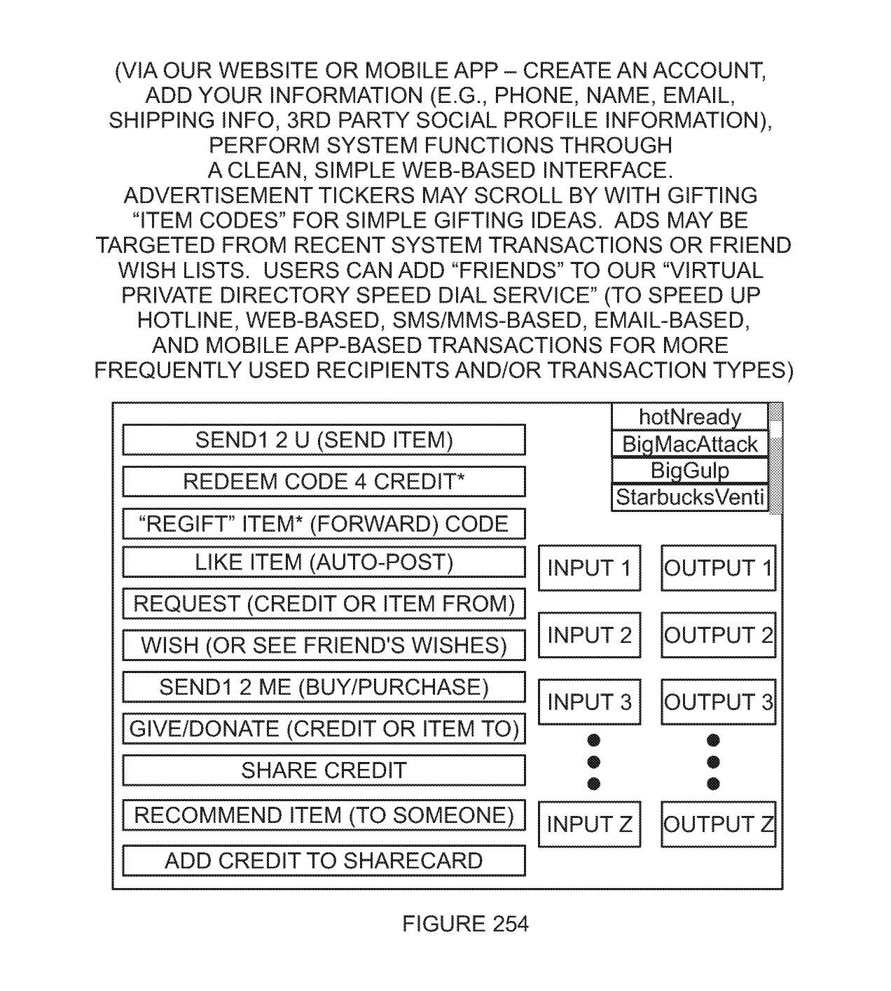

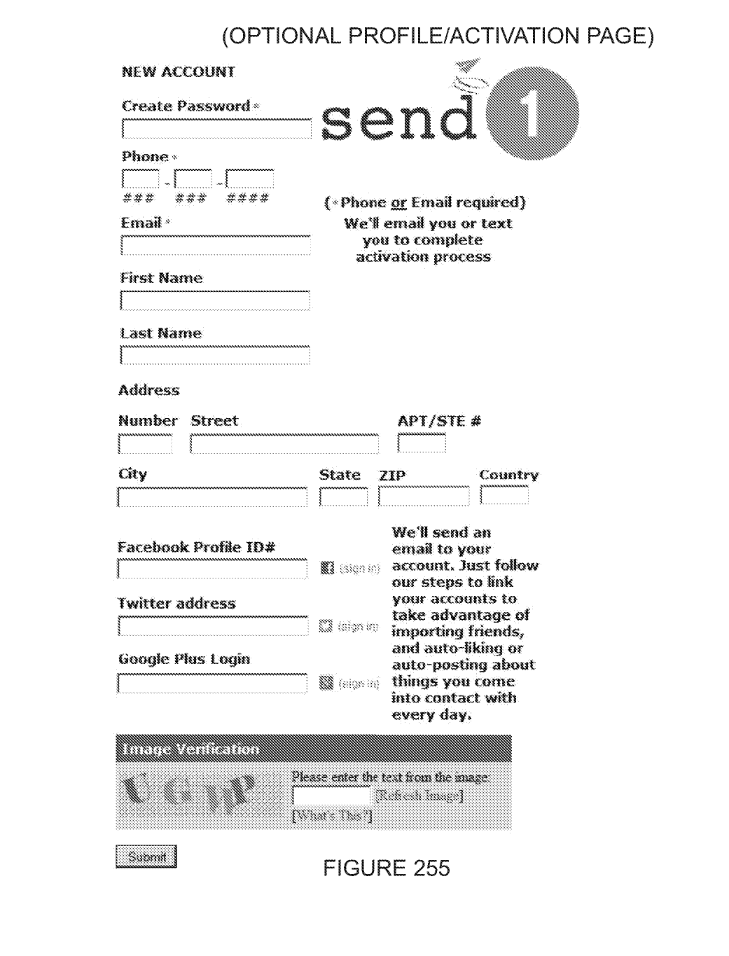

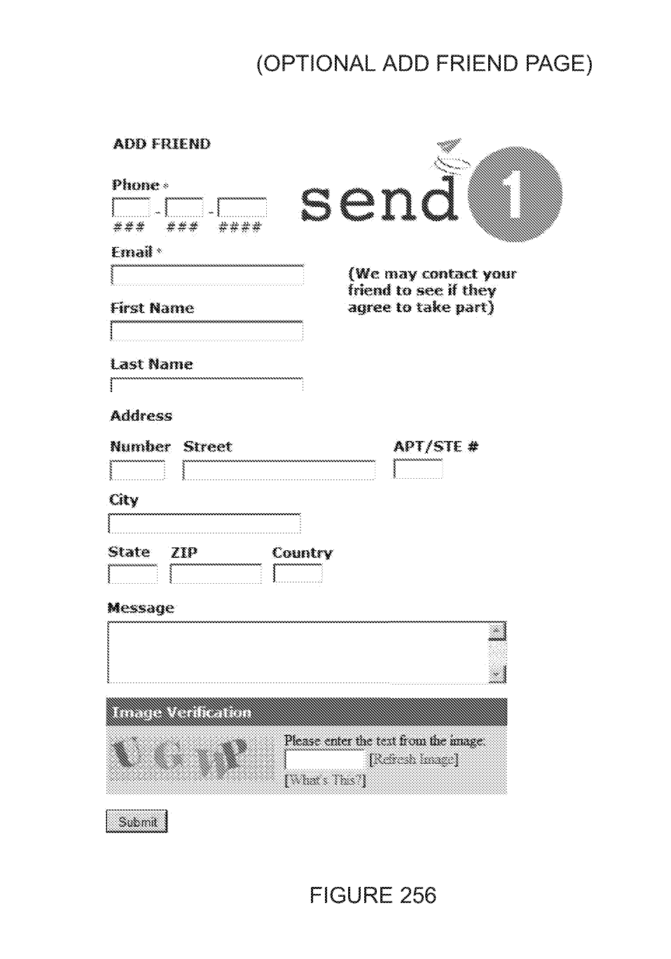

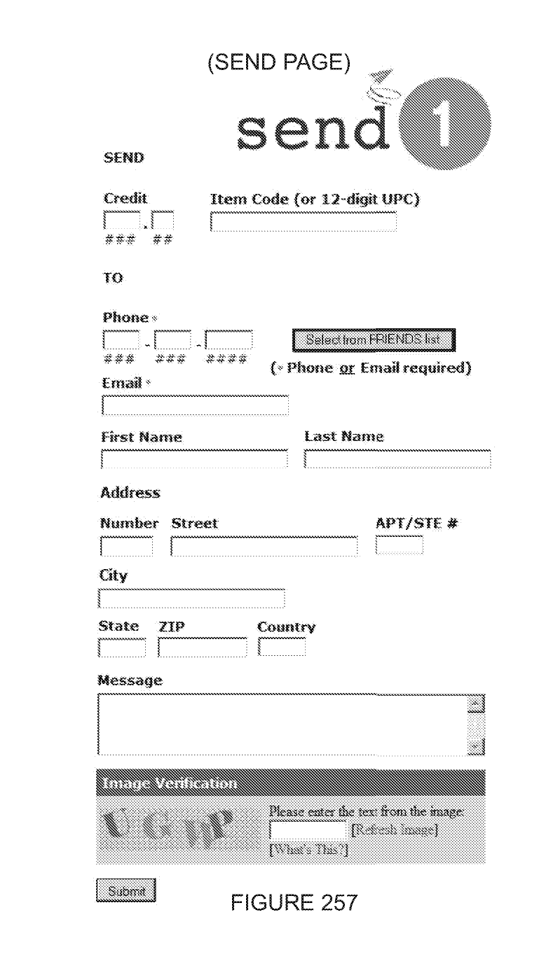

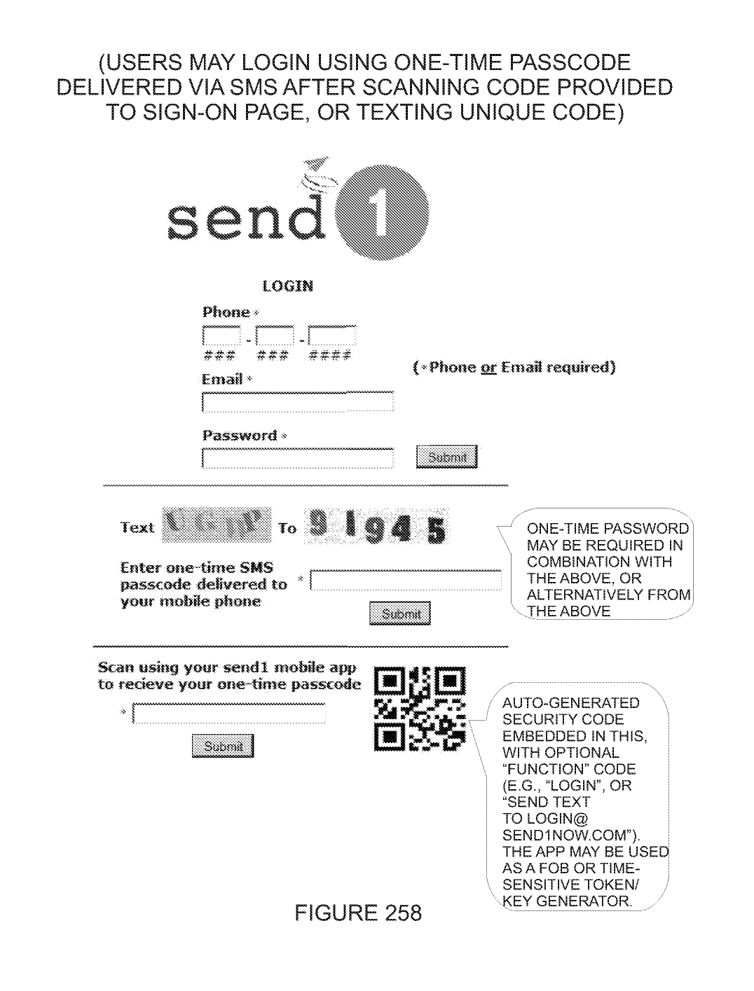

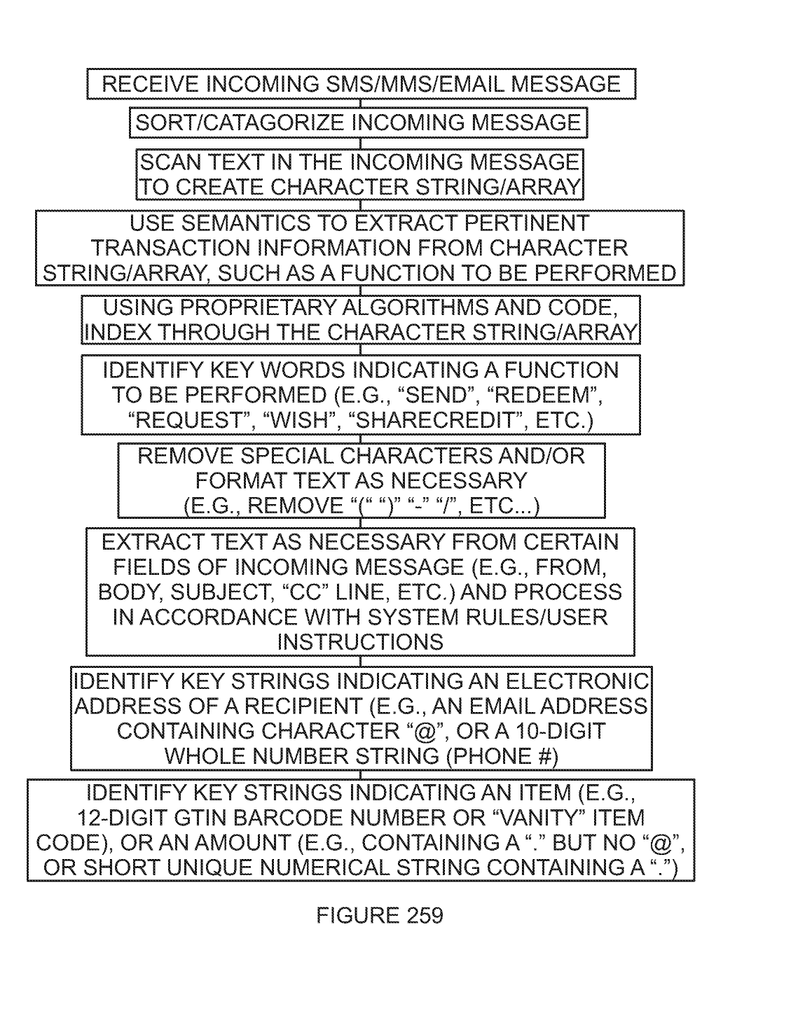

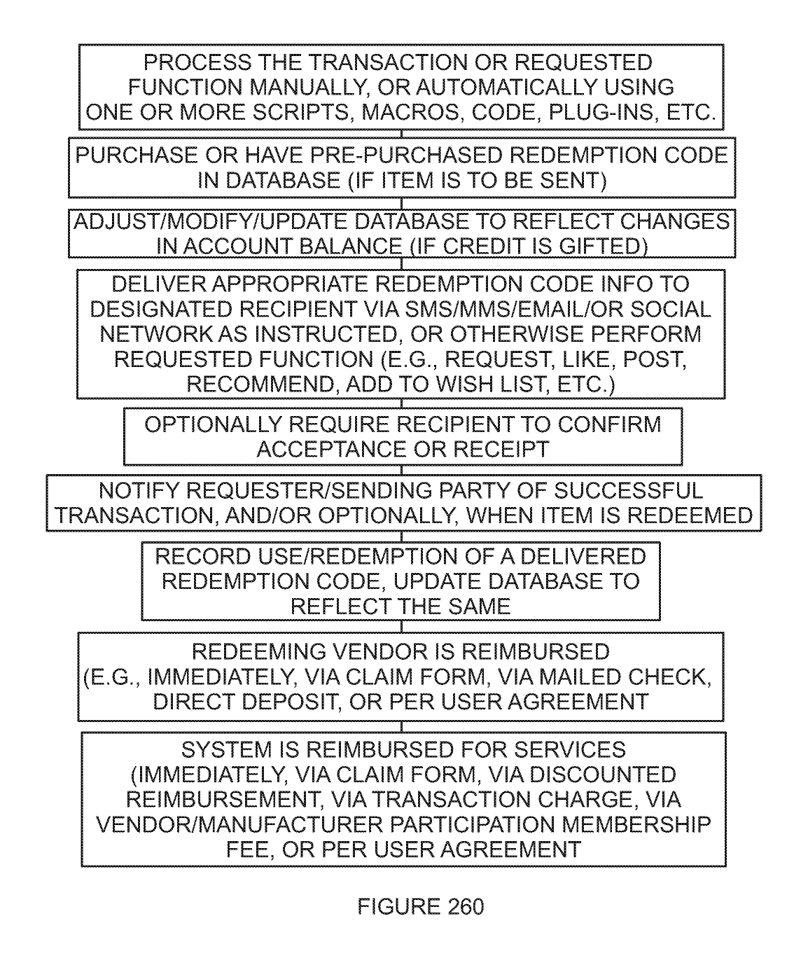

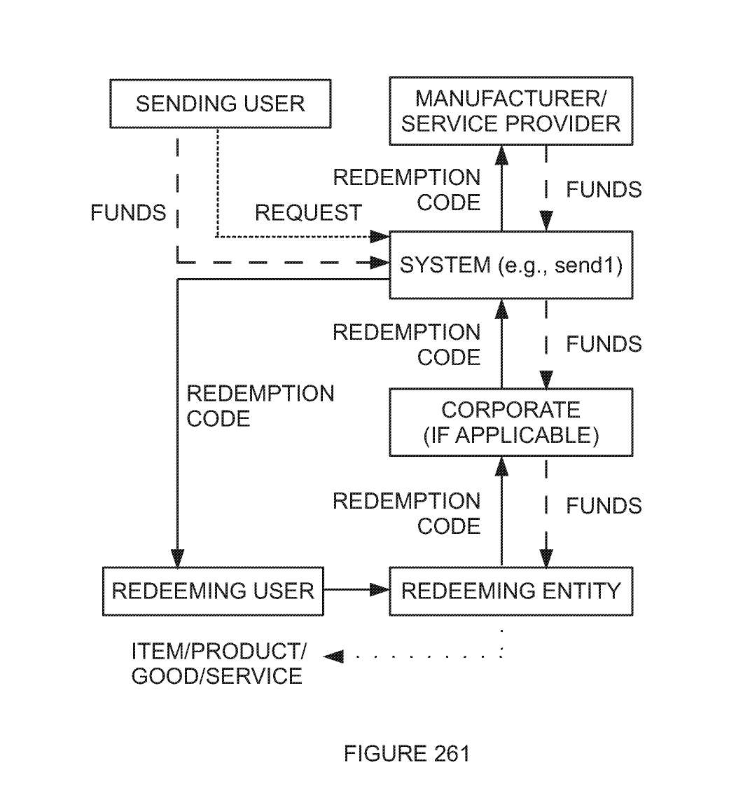

According to some embodiments, *.php,*.xml files, and/or equivalent server-side scripting means 147 may receive and/or handle incoming phone calls from users, for example, incoming phone calls which are directed to a system long code (e.g., “+1-307-200-2255”). This may be appreciated from at least FIGS. 238 and 241-252, without limitation. In some embodiments, information associated with user submissions to the system via a phone call (e.g., via POST data) containing user inputs 4 comprising transaction data may be populated within a system database 129, and/or database information may be manipulated based upon the data associated with the user inputs 4; wherein the software 147 (e.g., the *.php,*.xml files, and/or equivalent server-side scripting means) may facilitate the provision of one or more system communications to one or more sending users and/or one or more recipient users, without limitation.

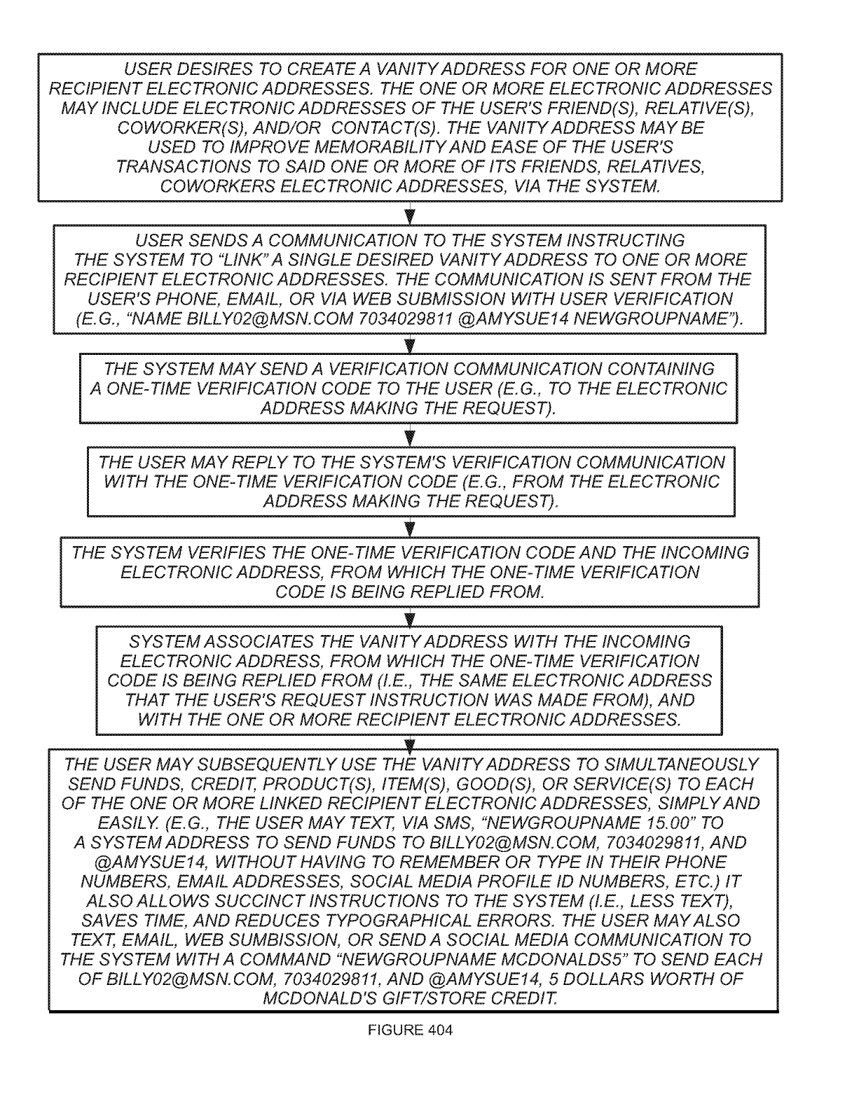

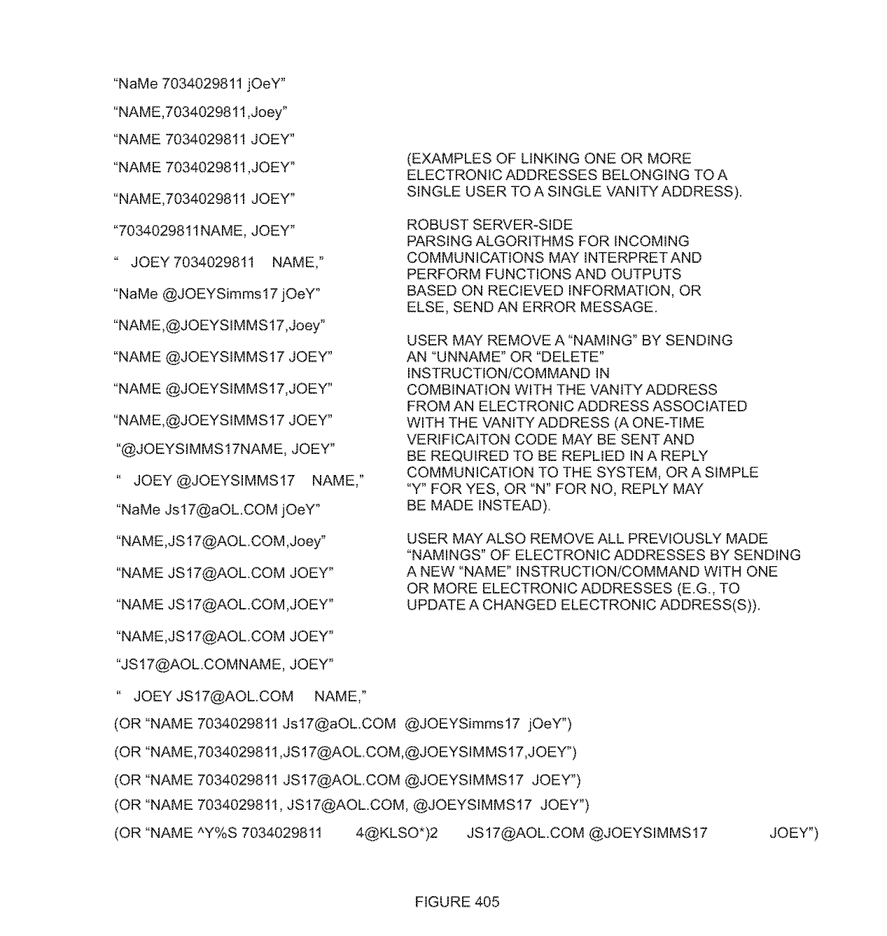

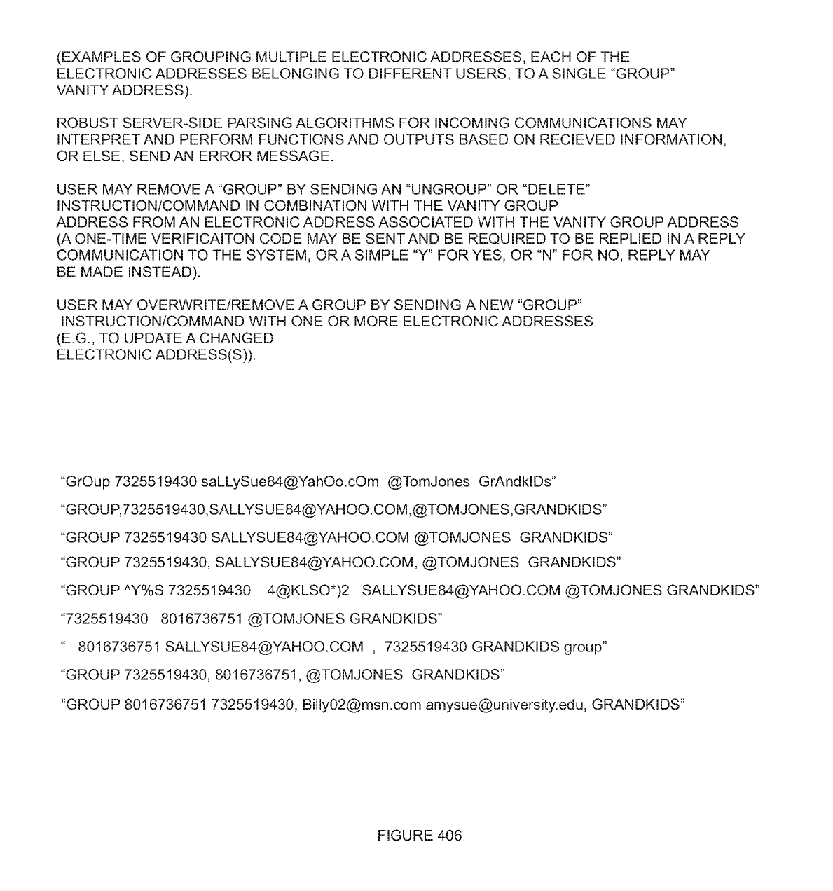

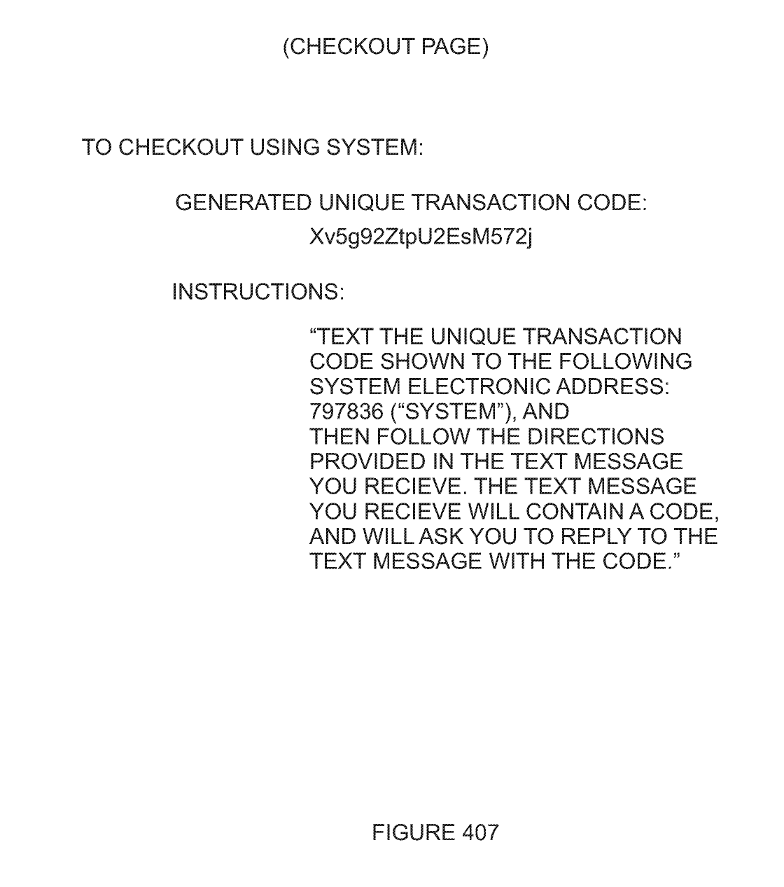

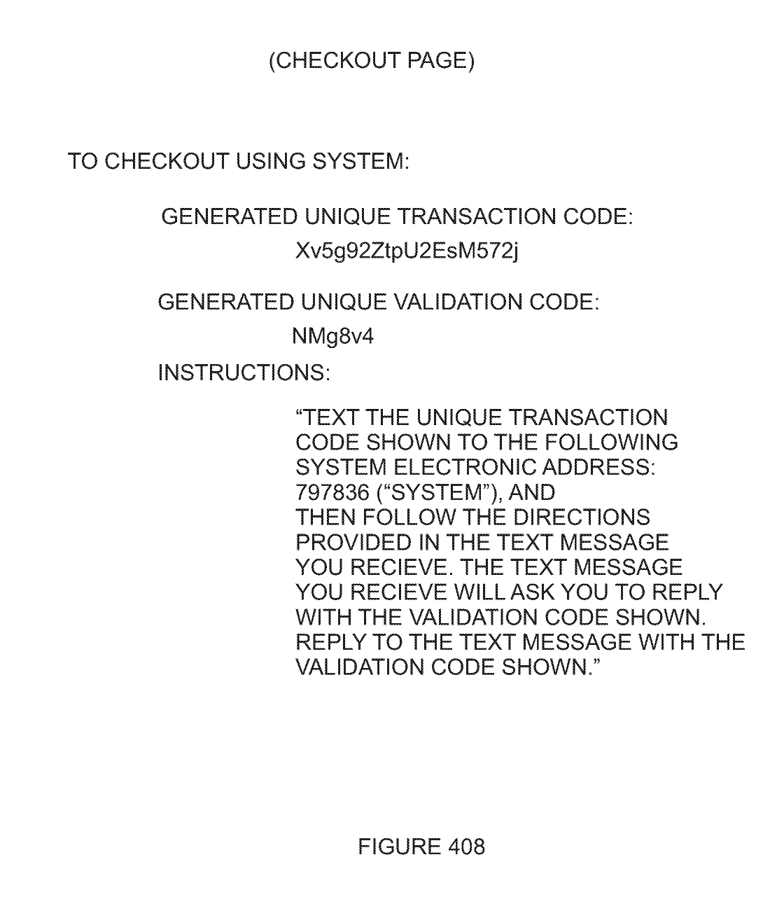

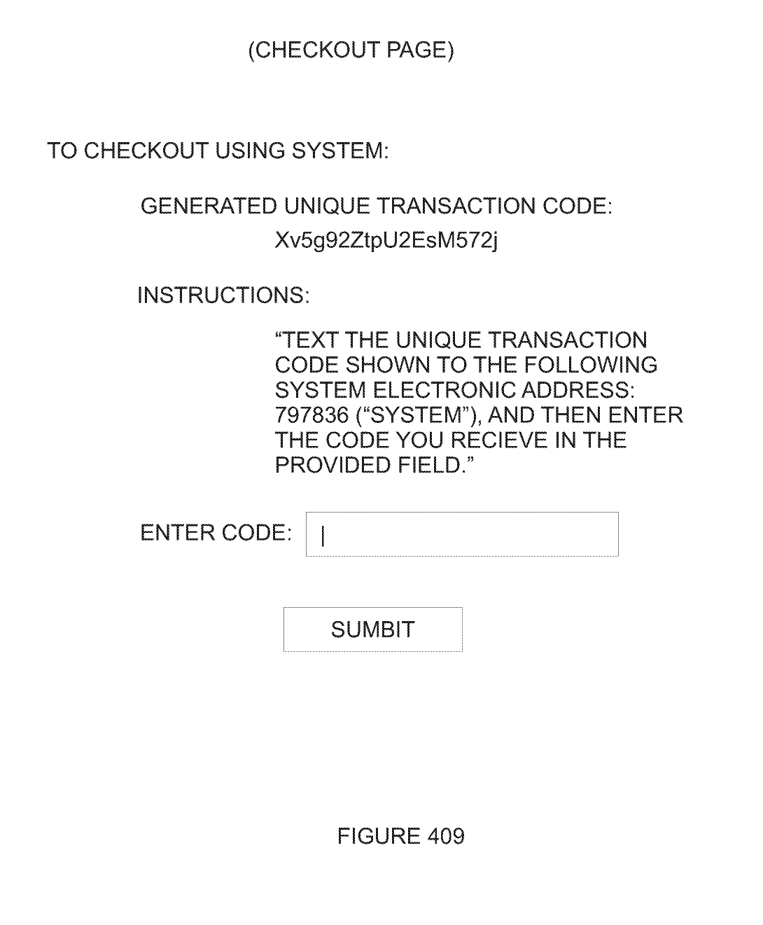

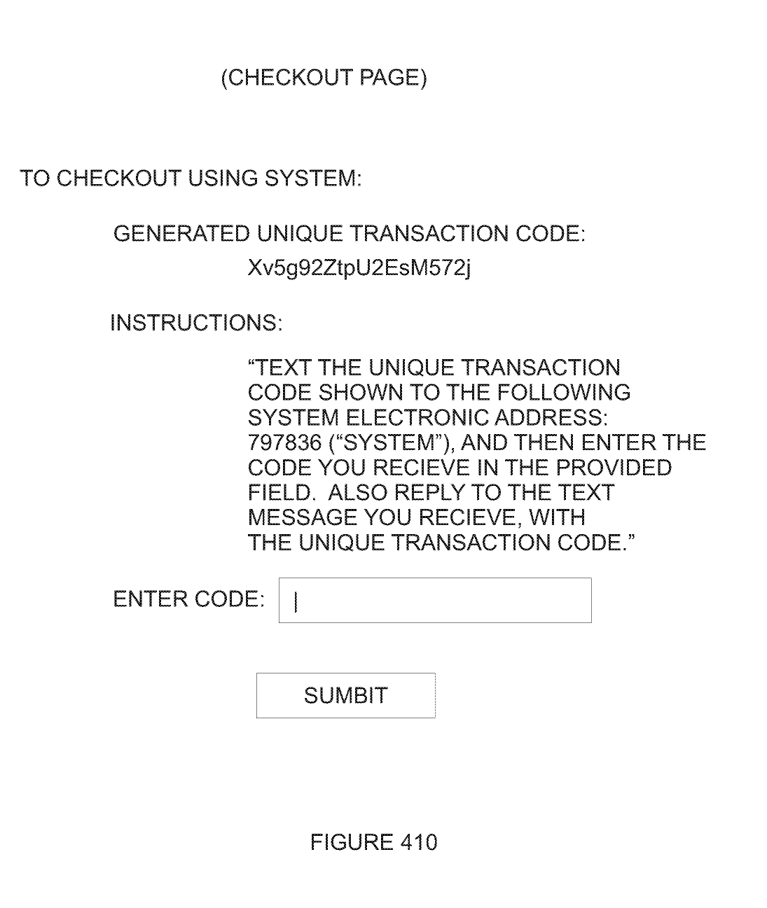

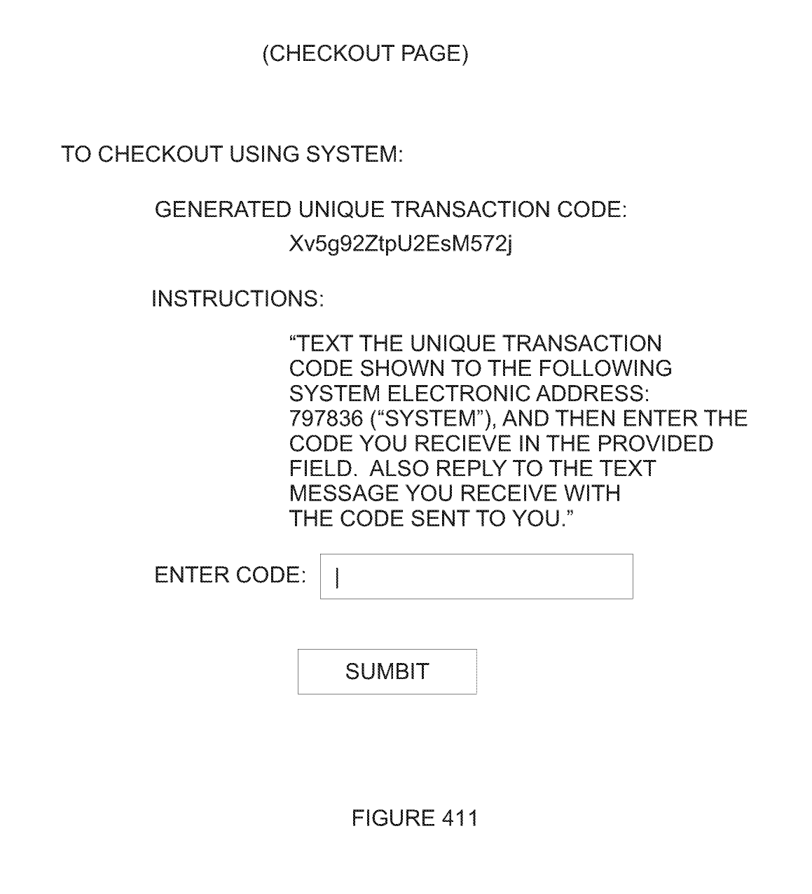

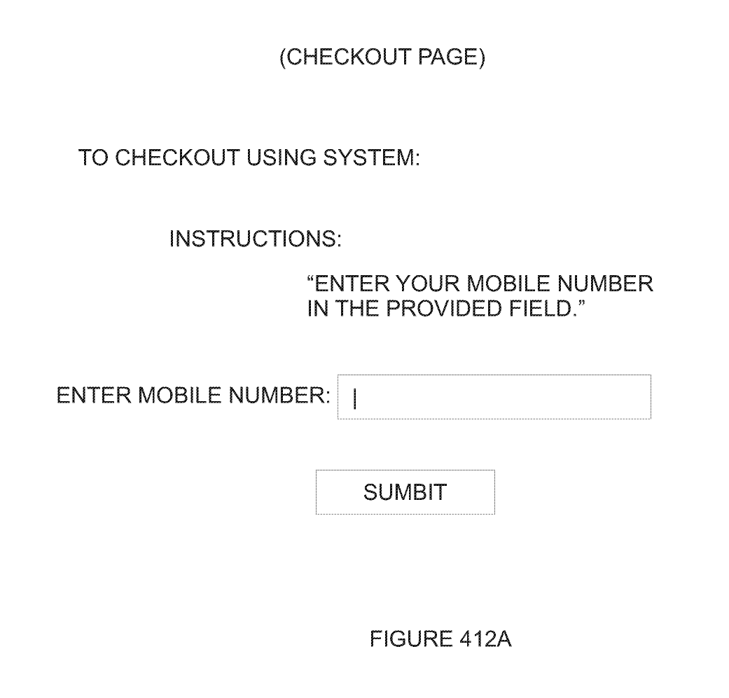

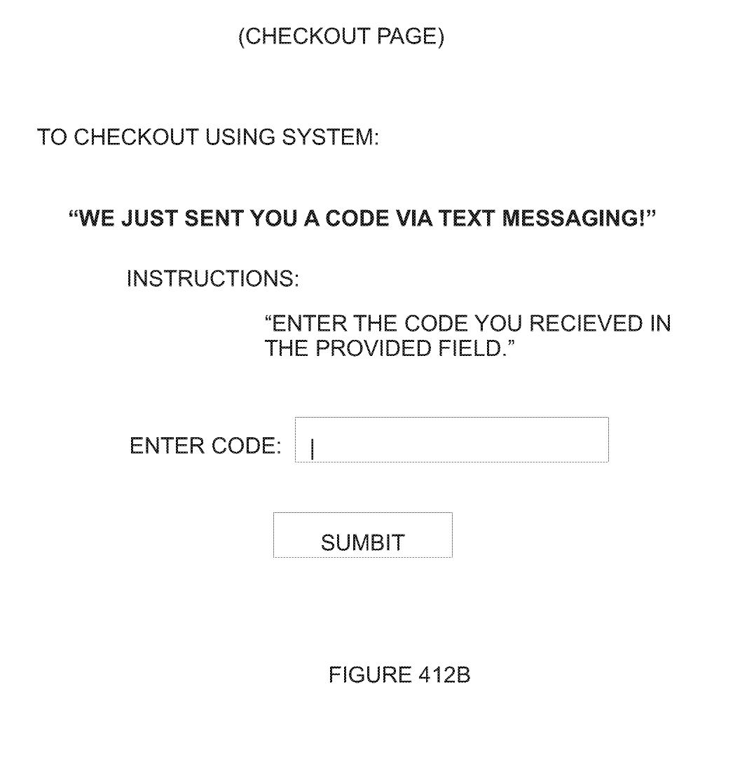

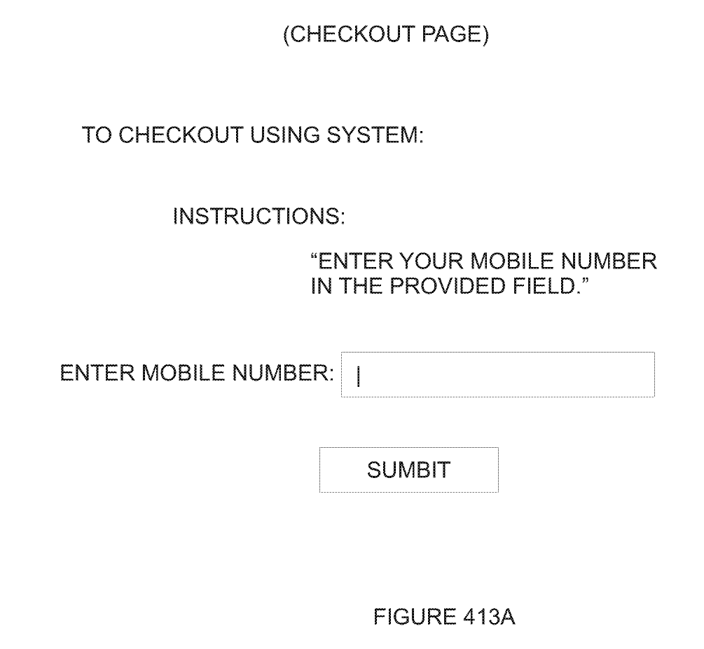

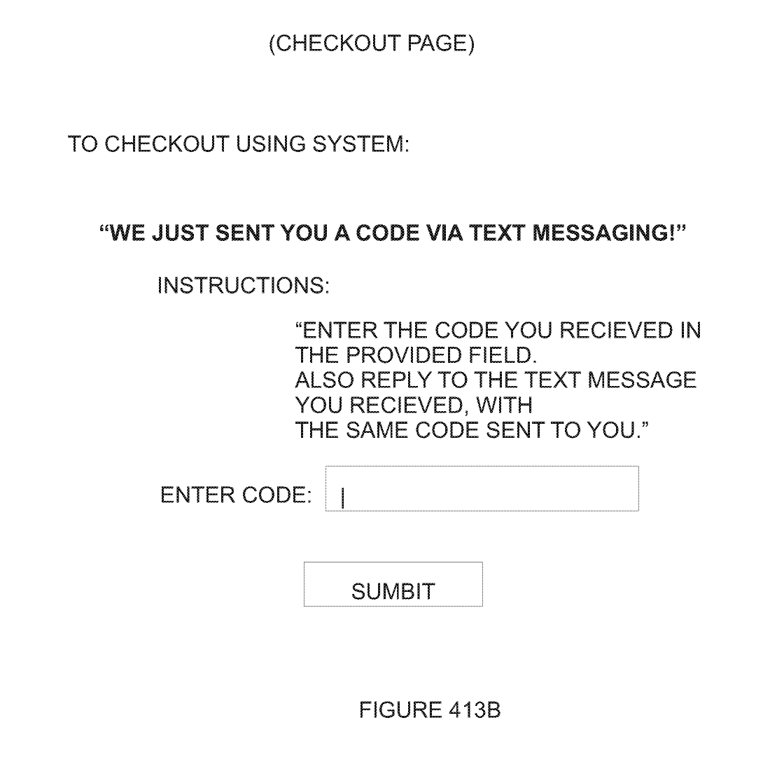

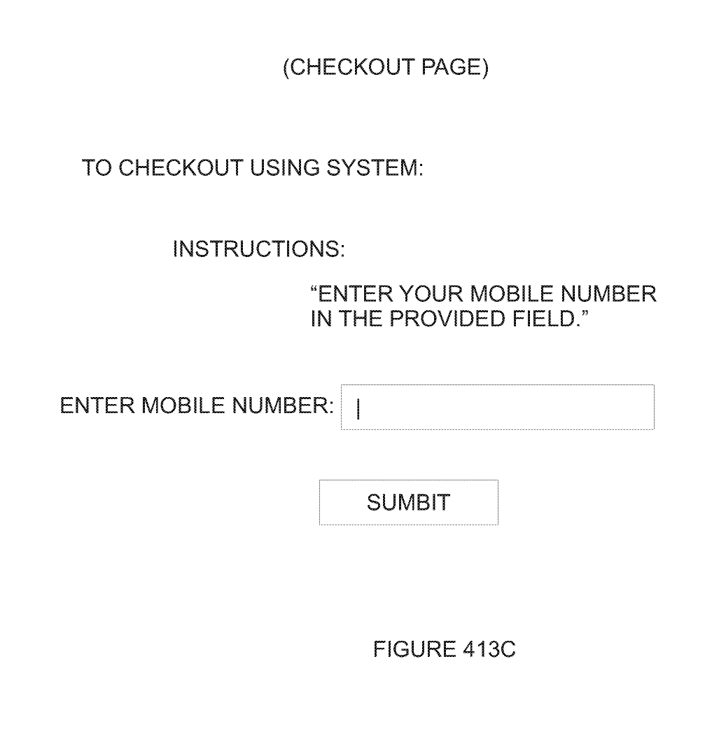

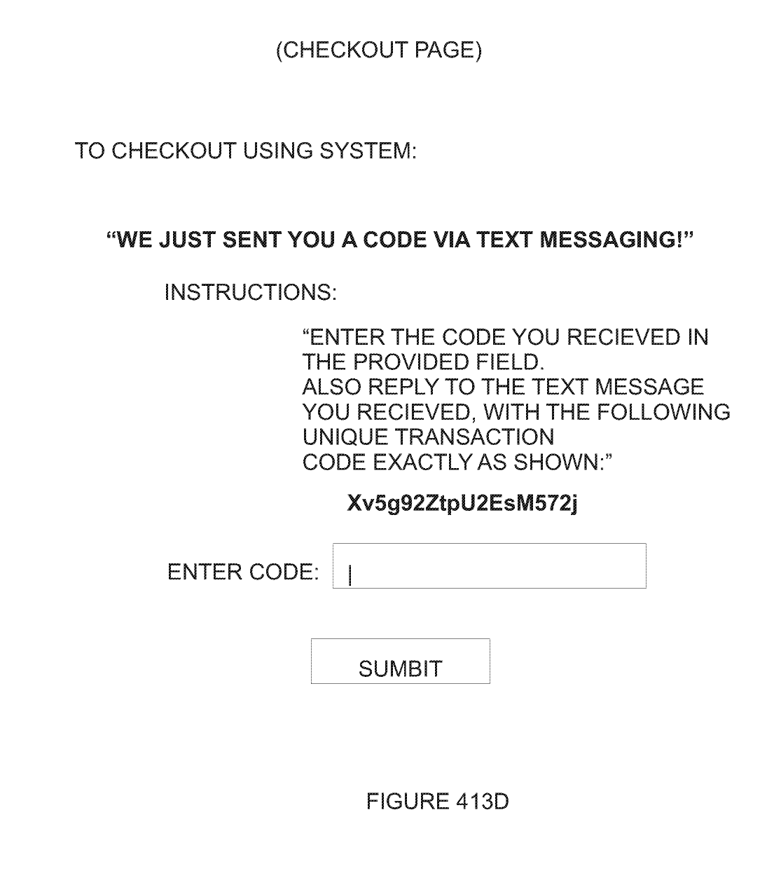

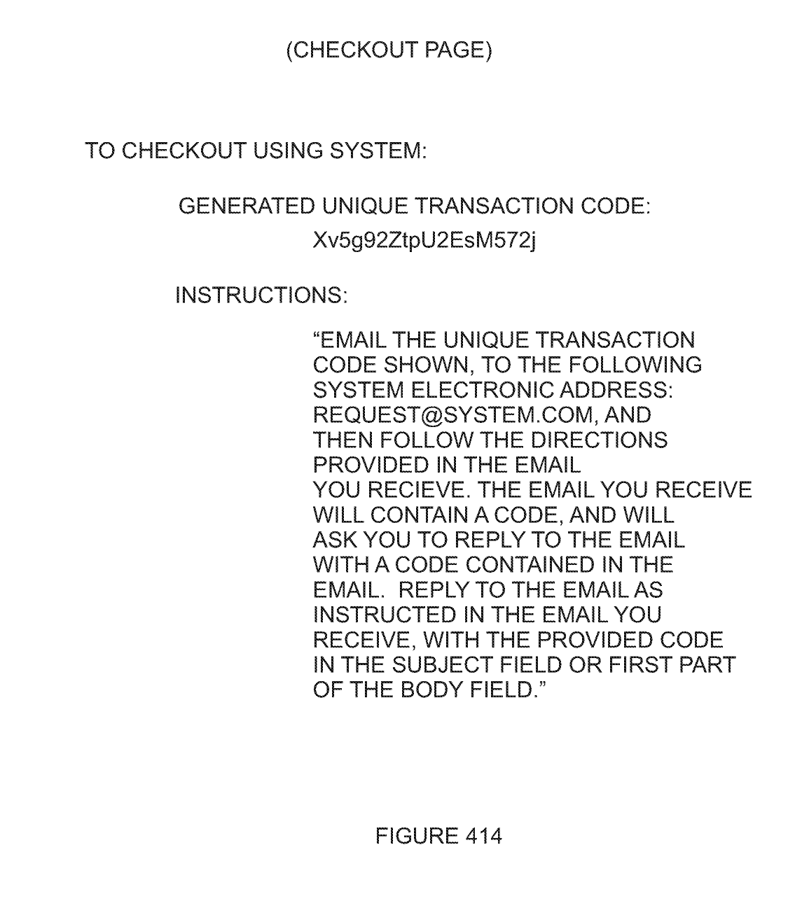

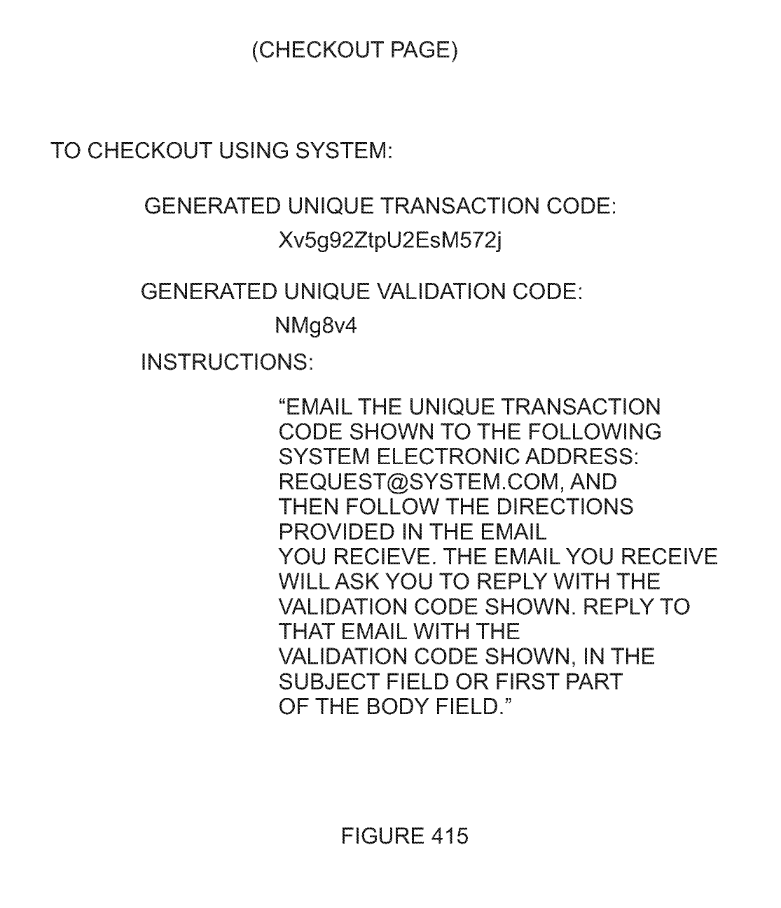

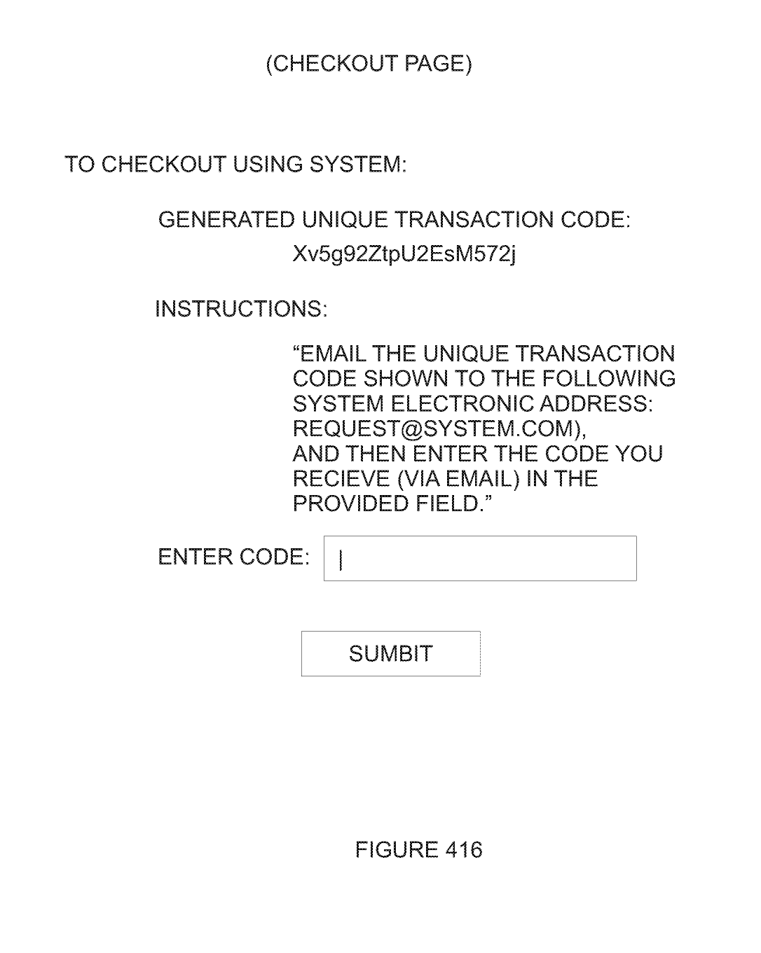

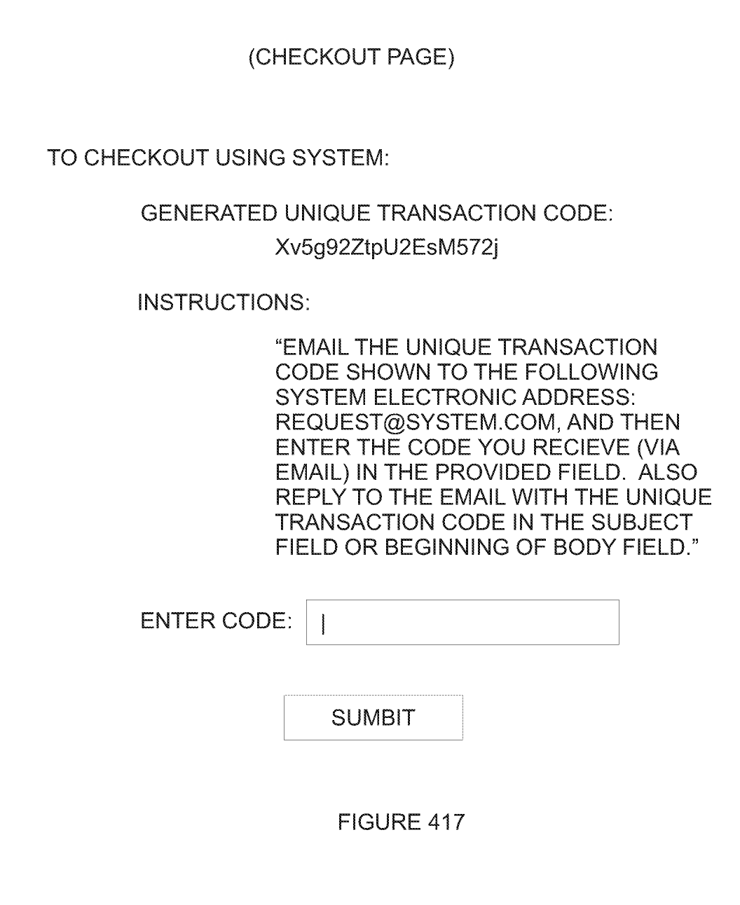

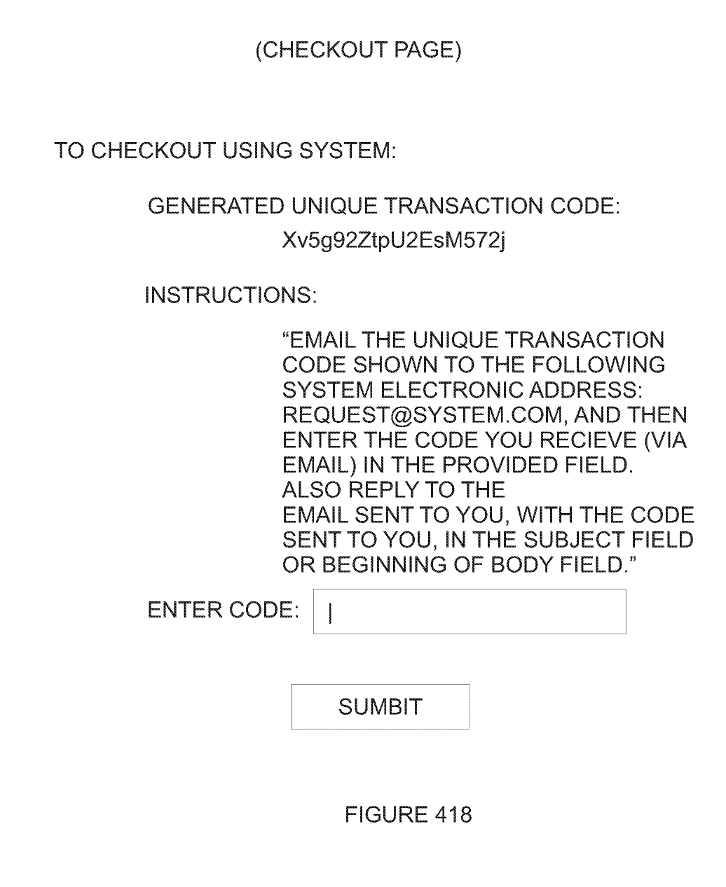

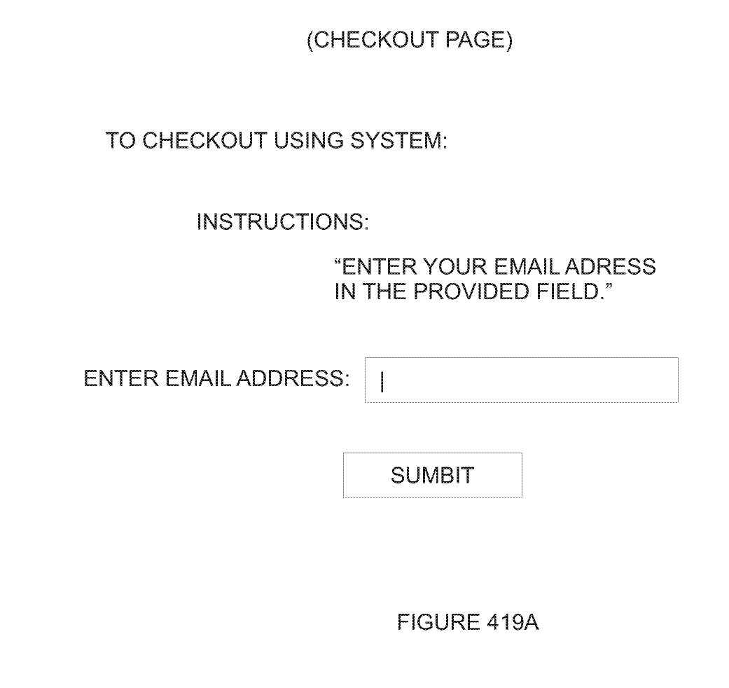

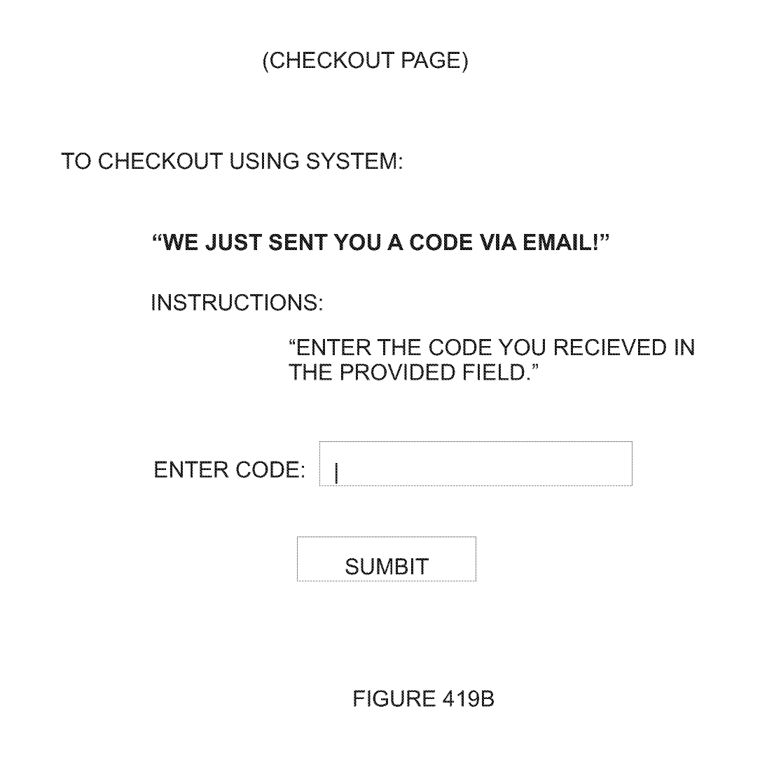

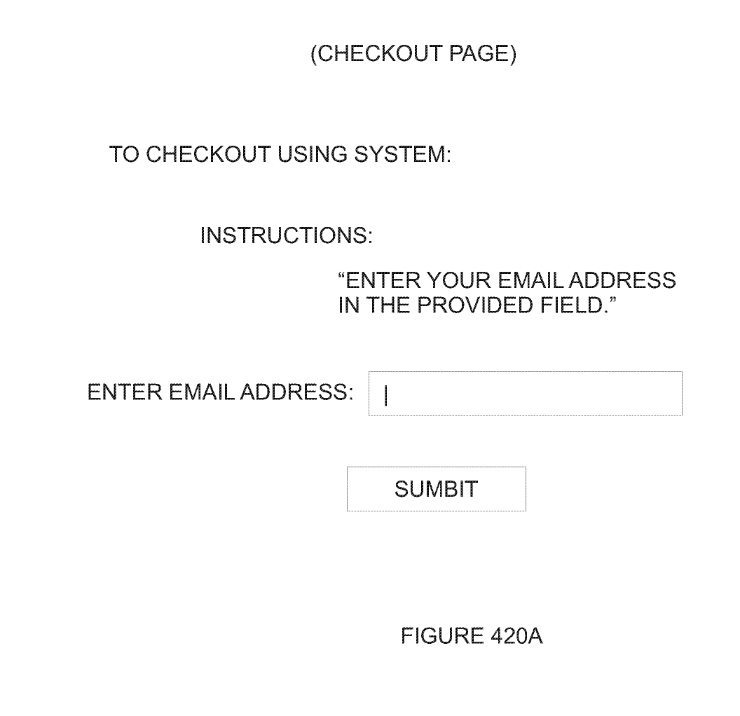

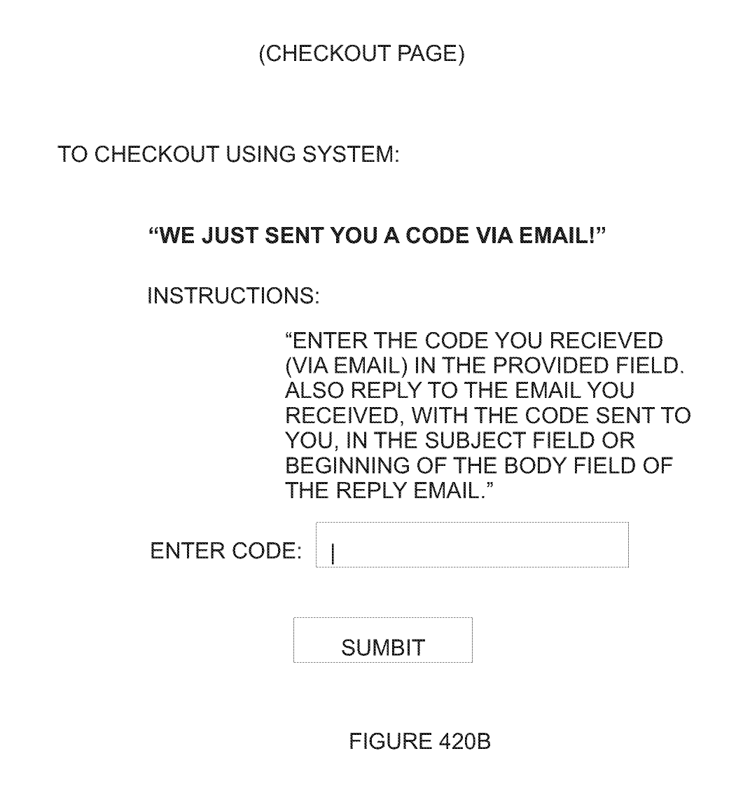

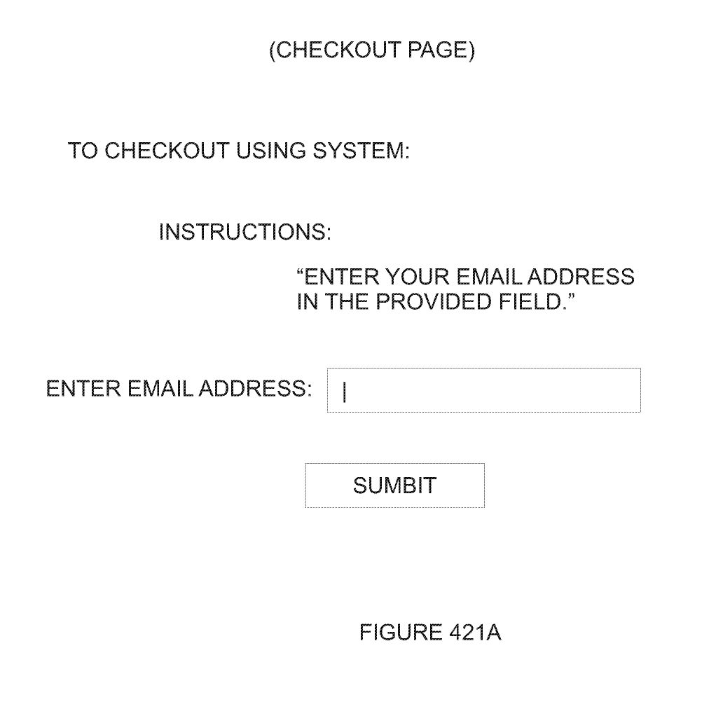

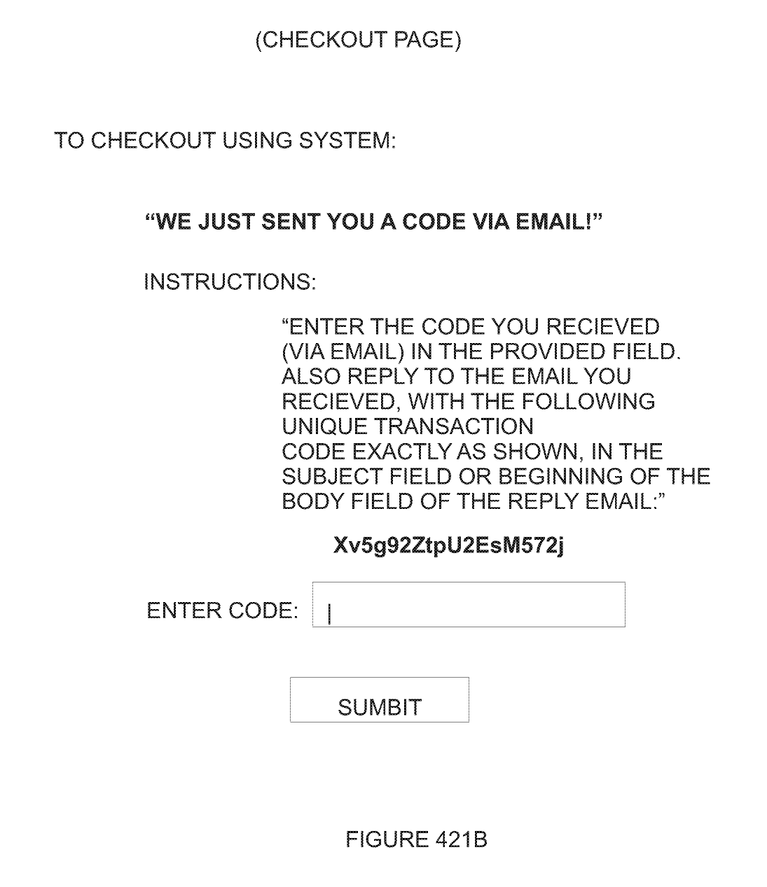

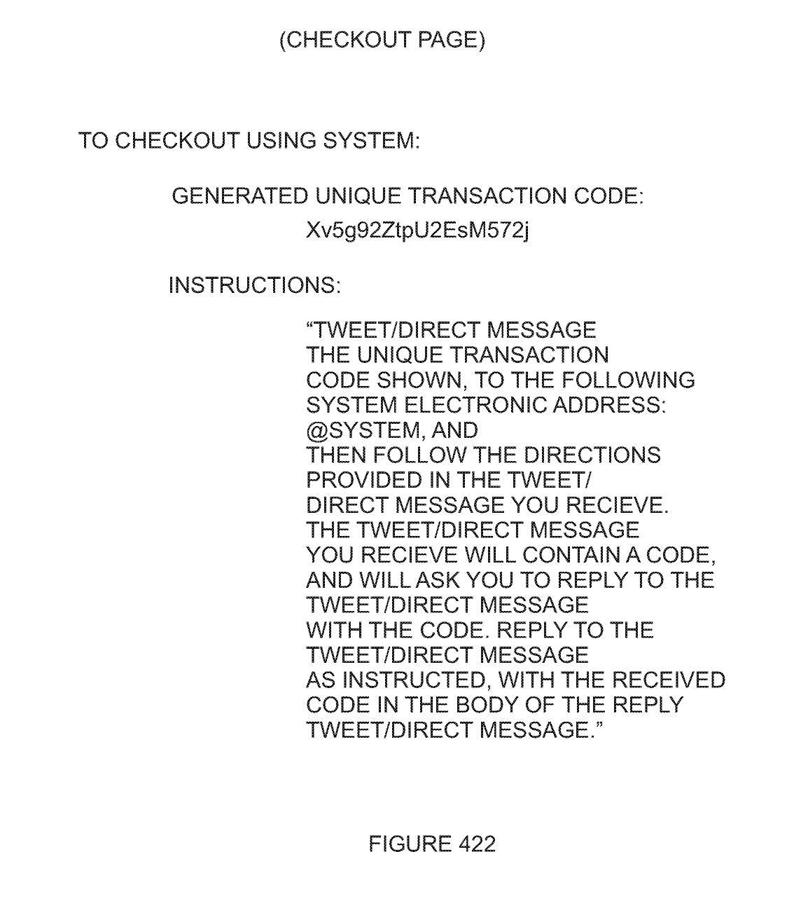

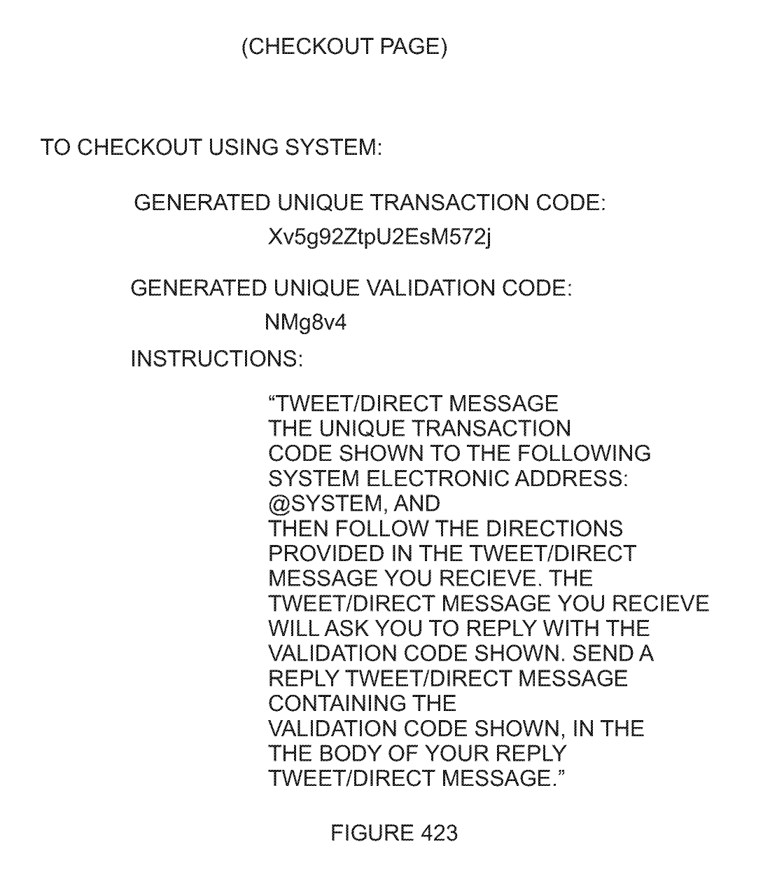

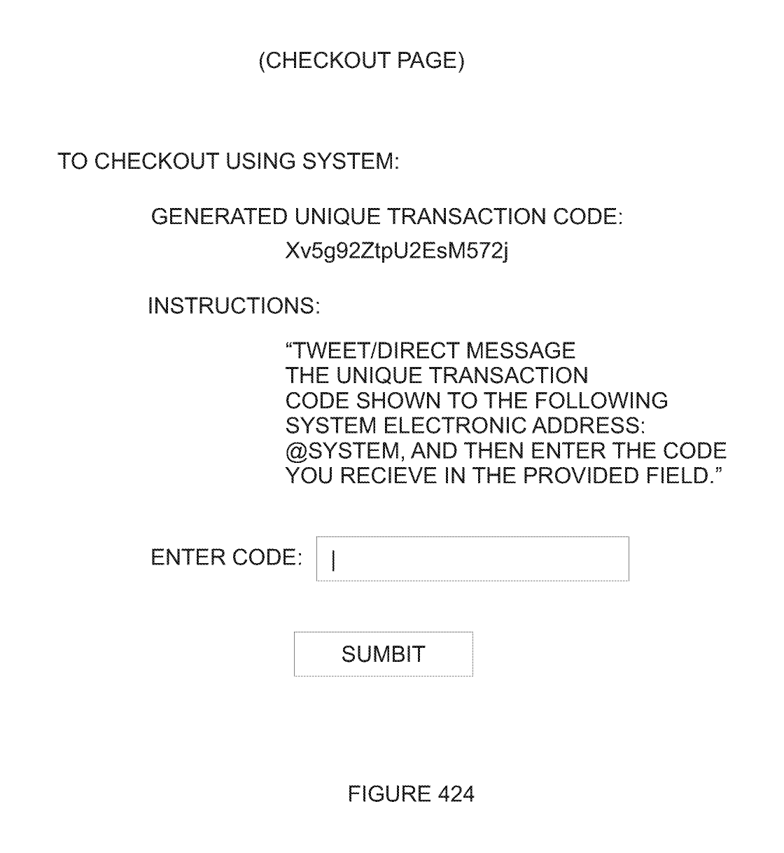

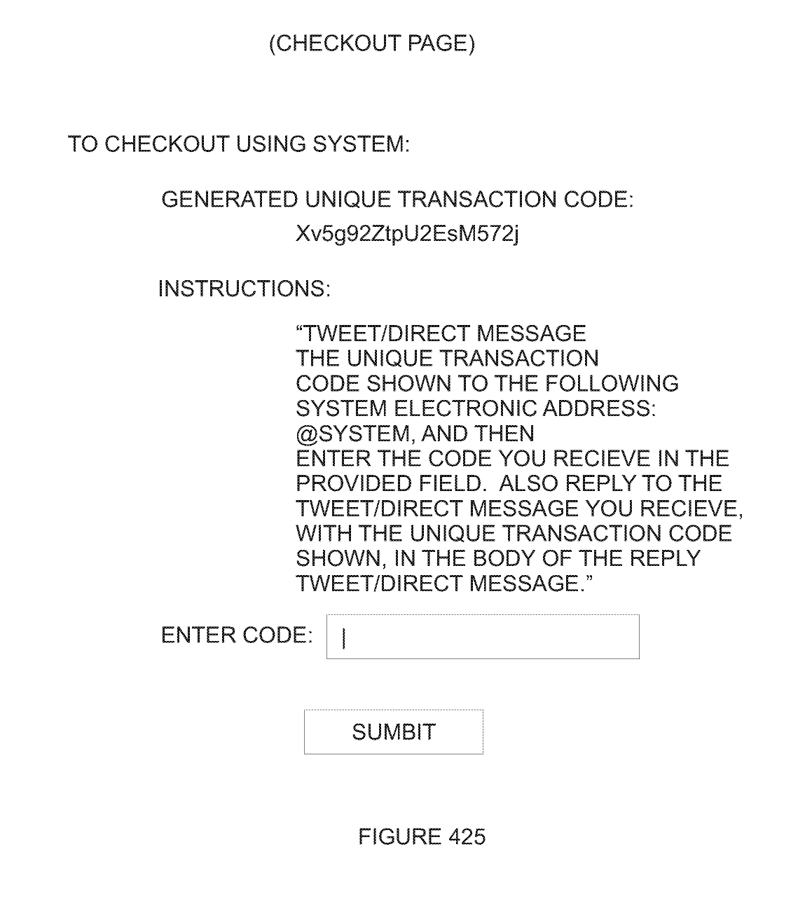

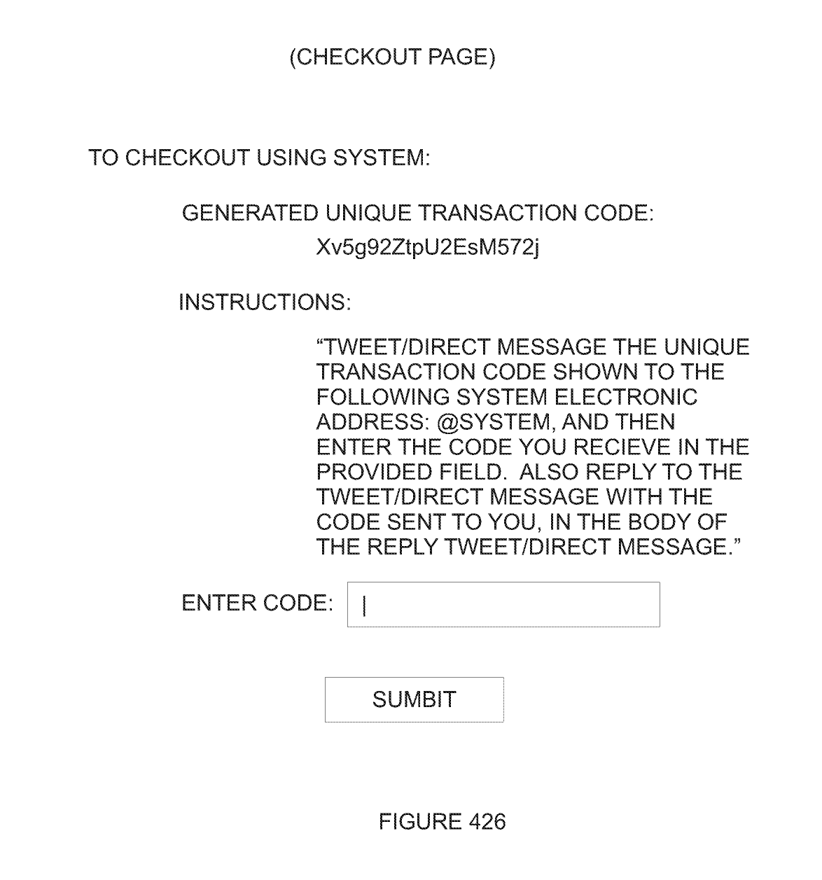

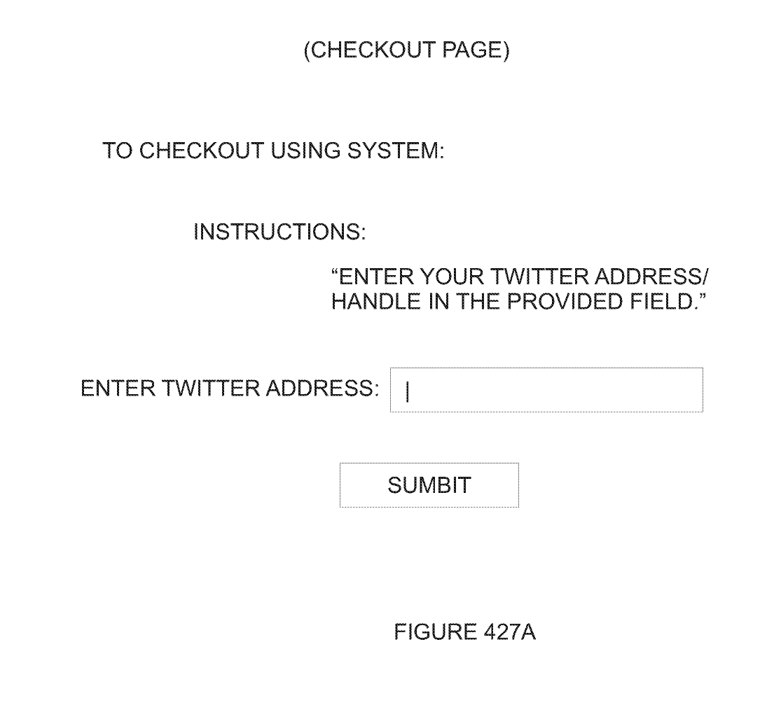

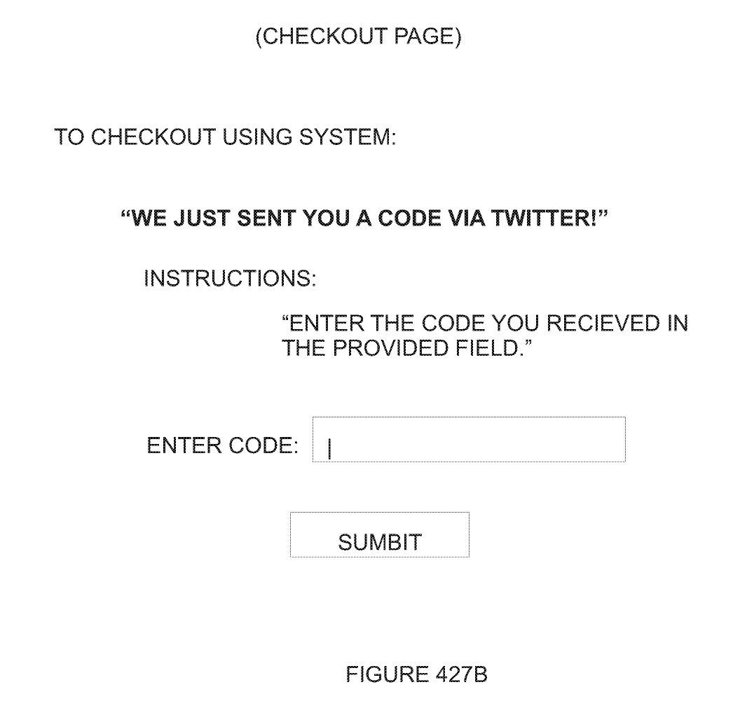

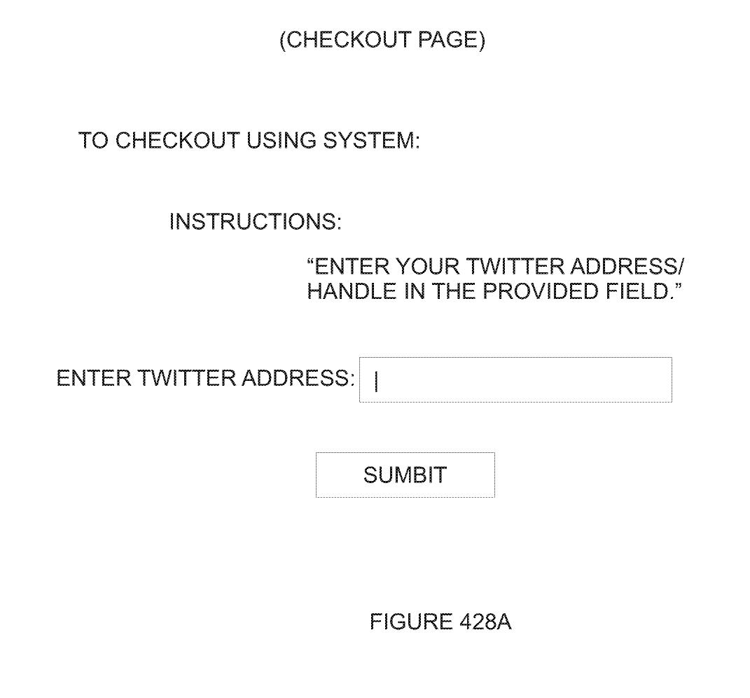

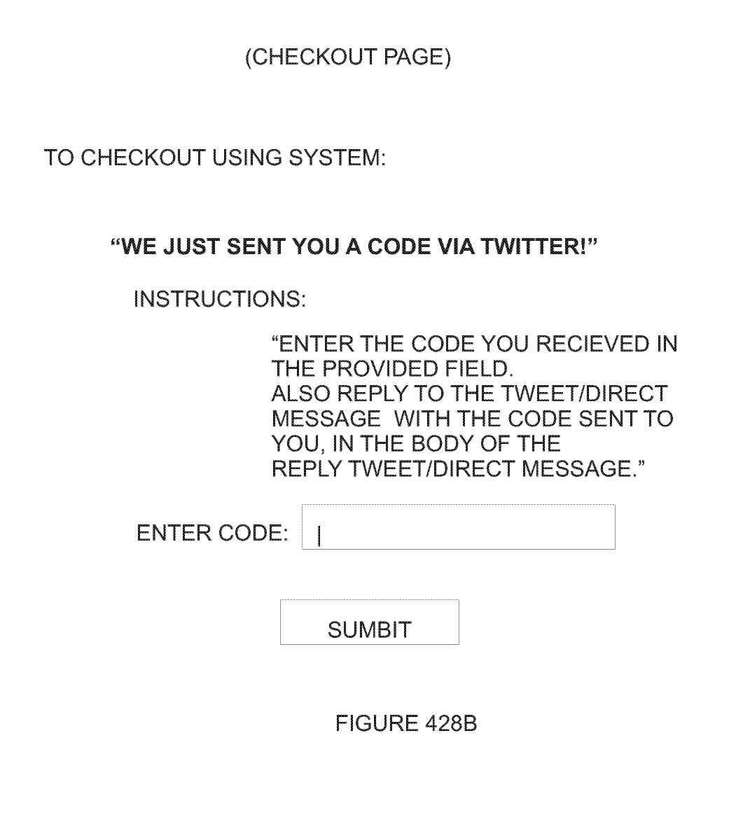

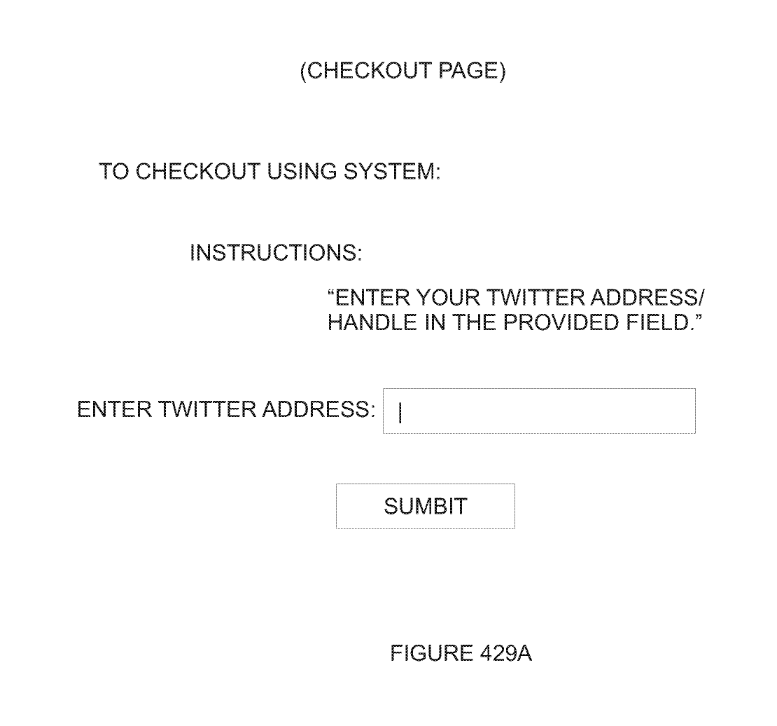

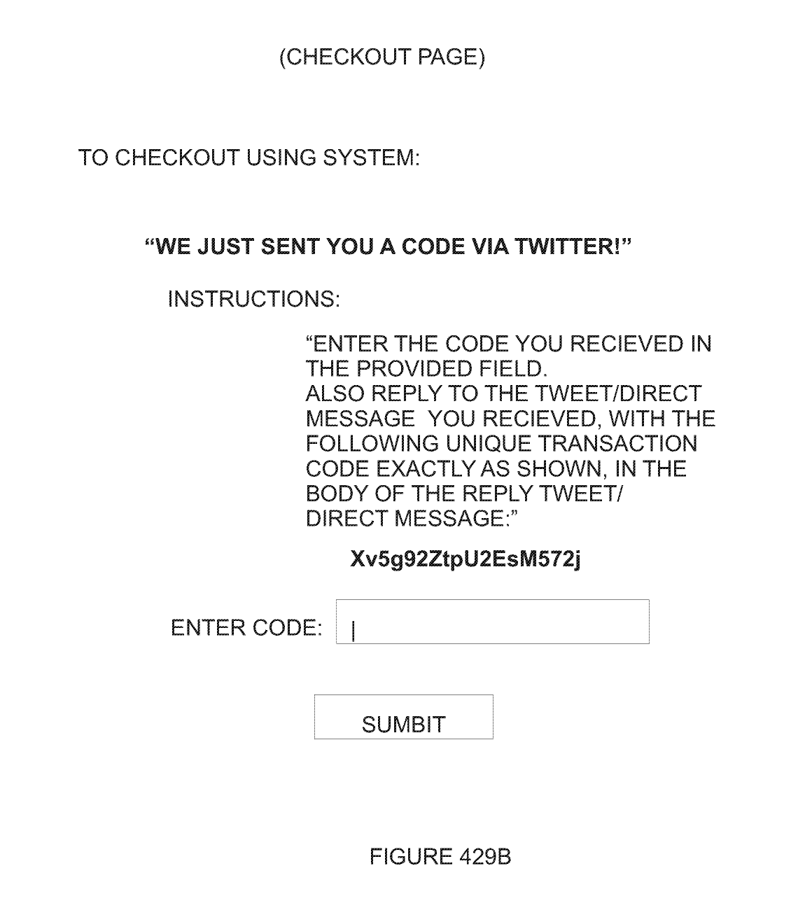

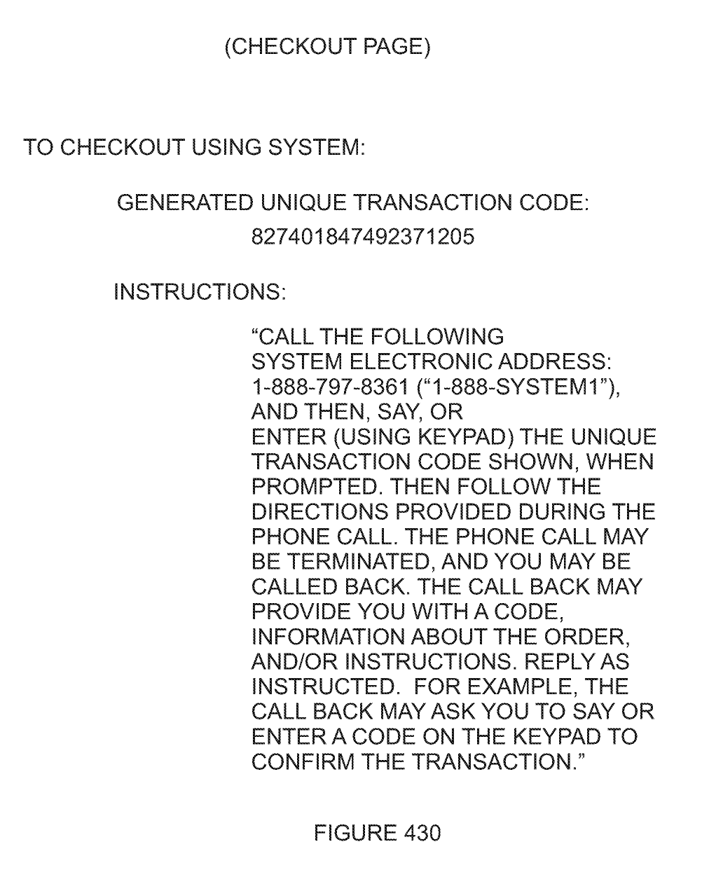

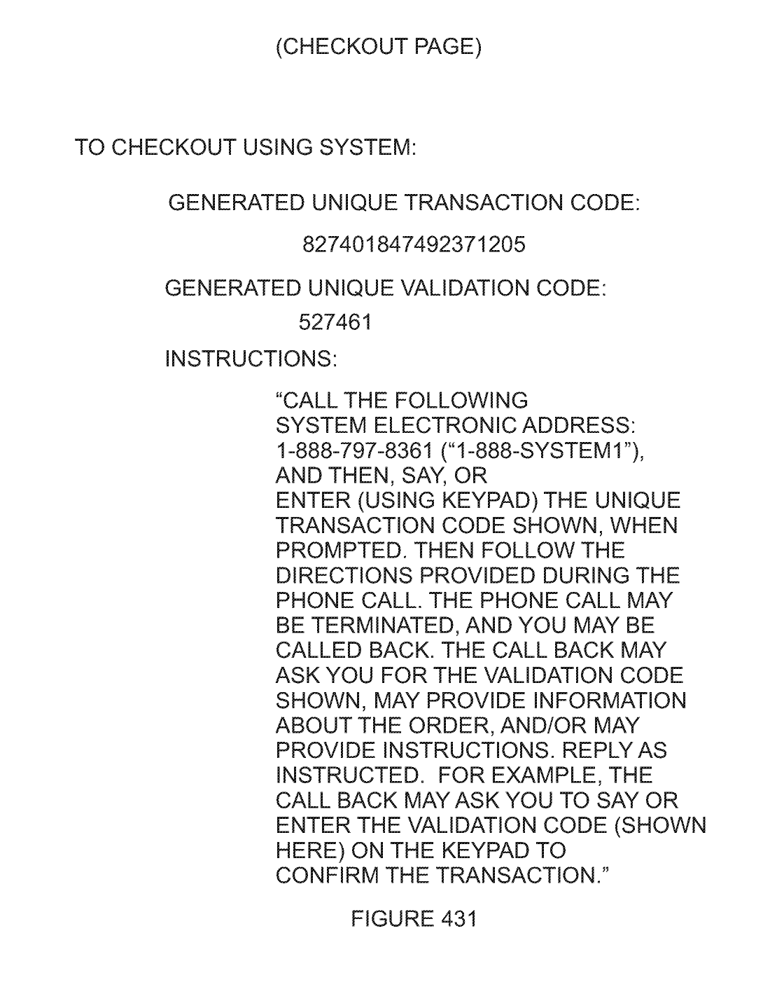

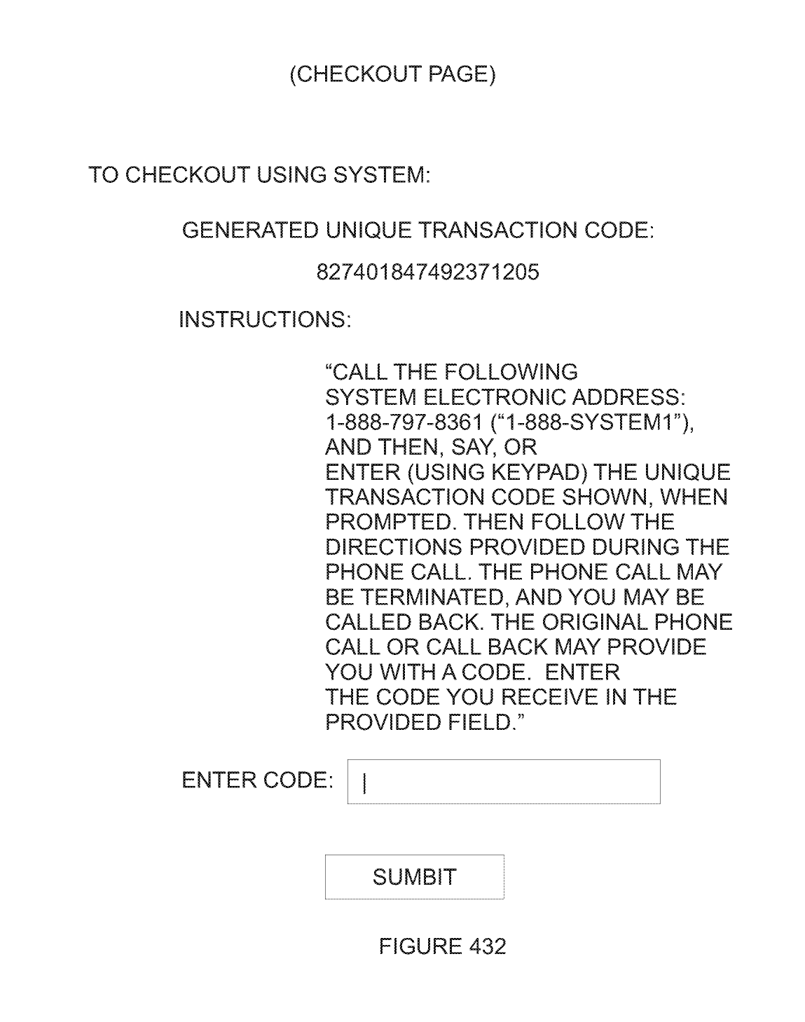

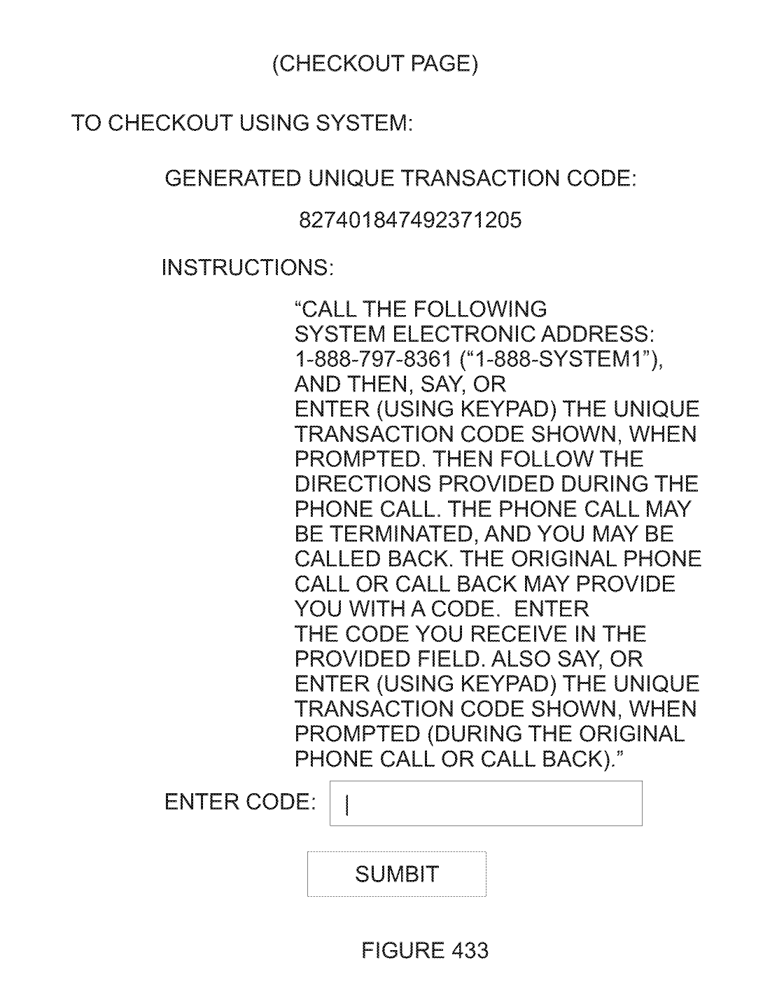

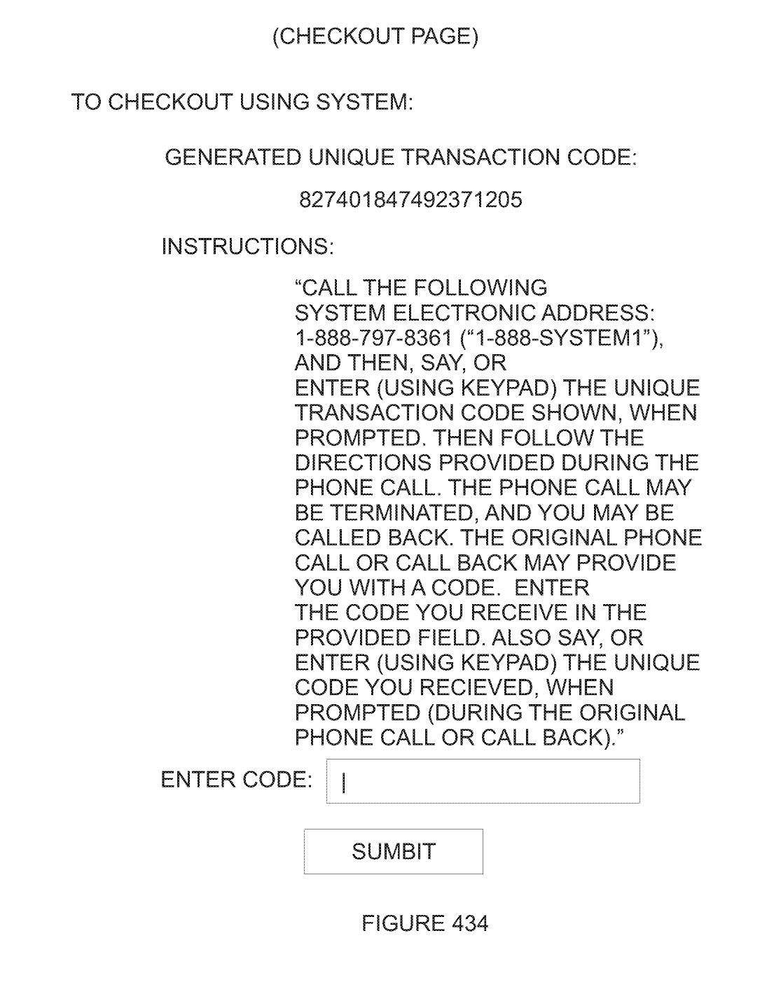

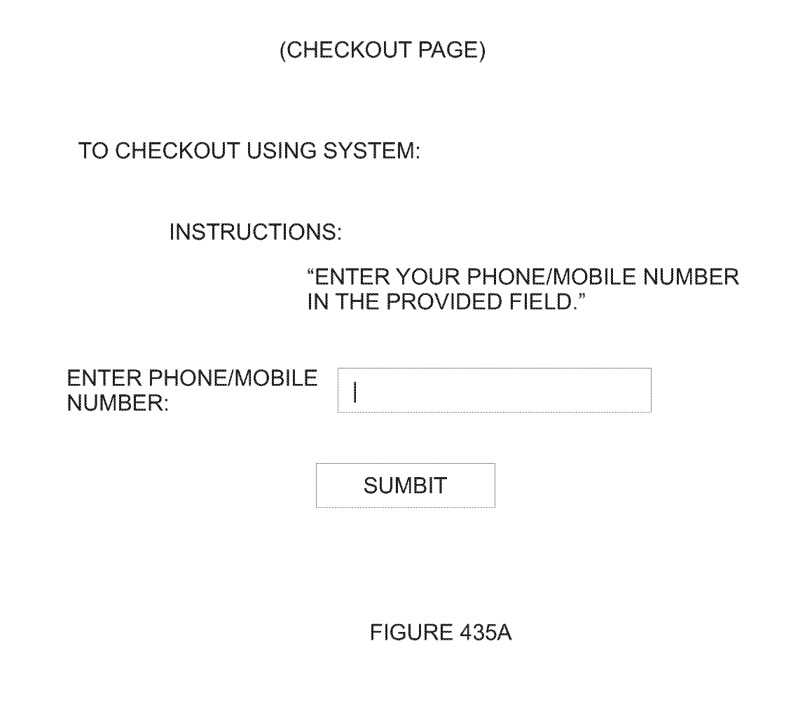

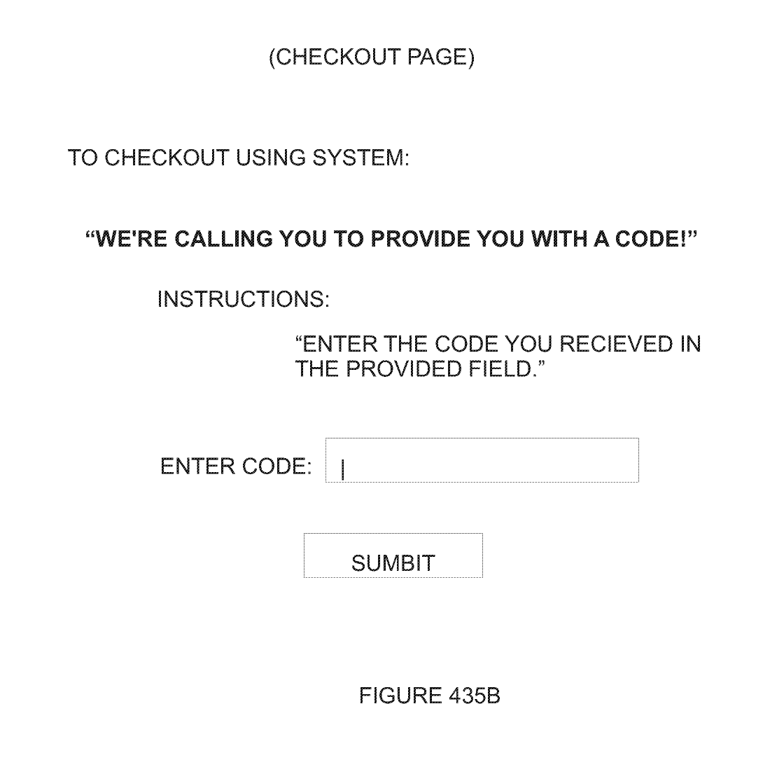

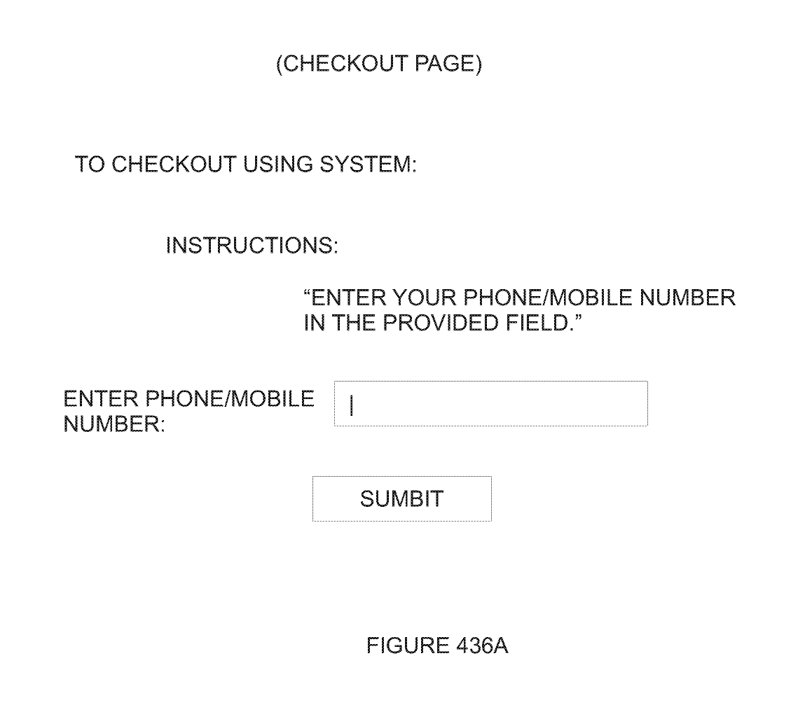

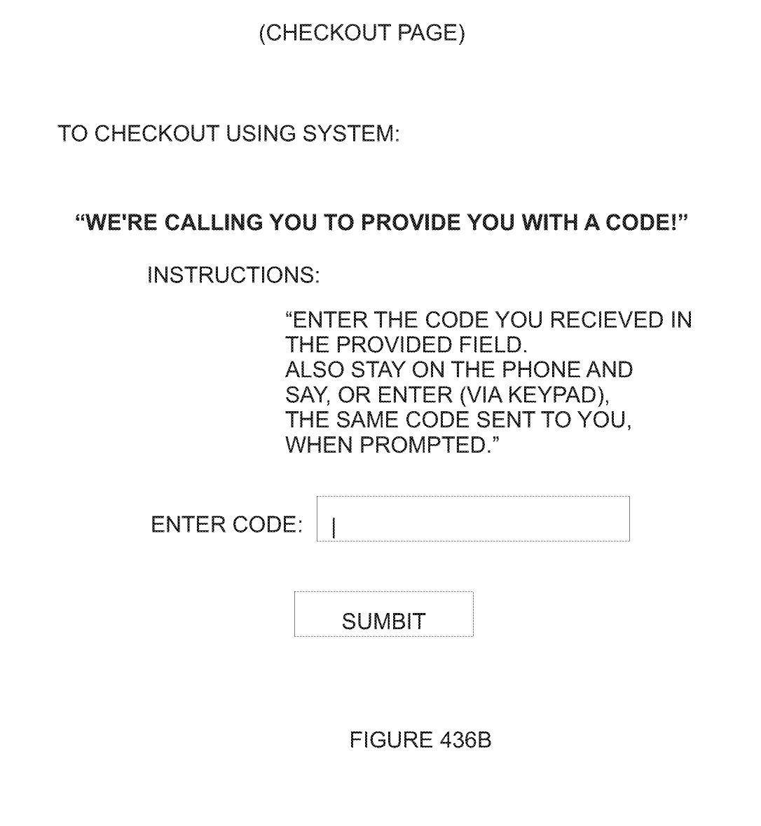

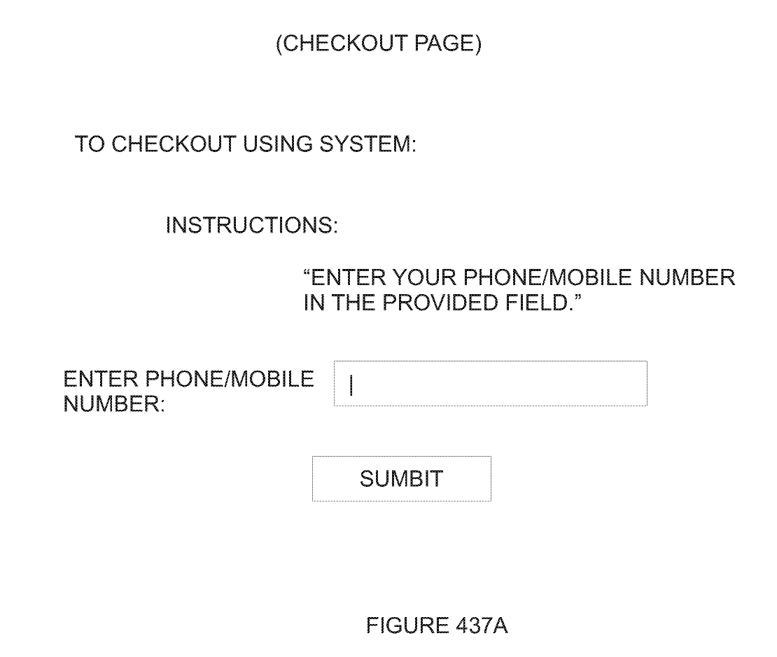

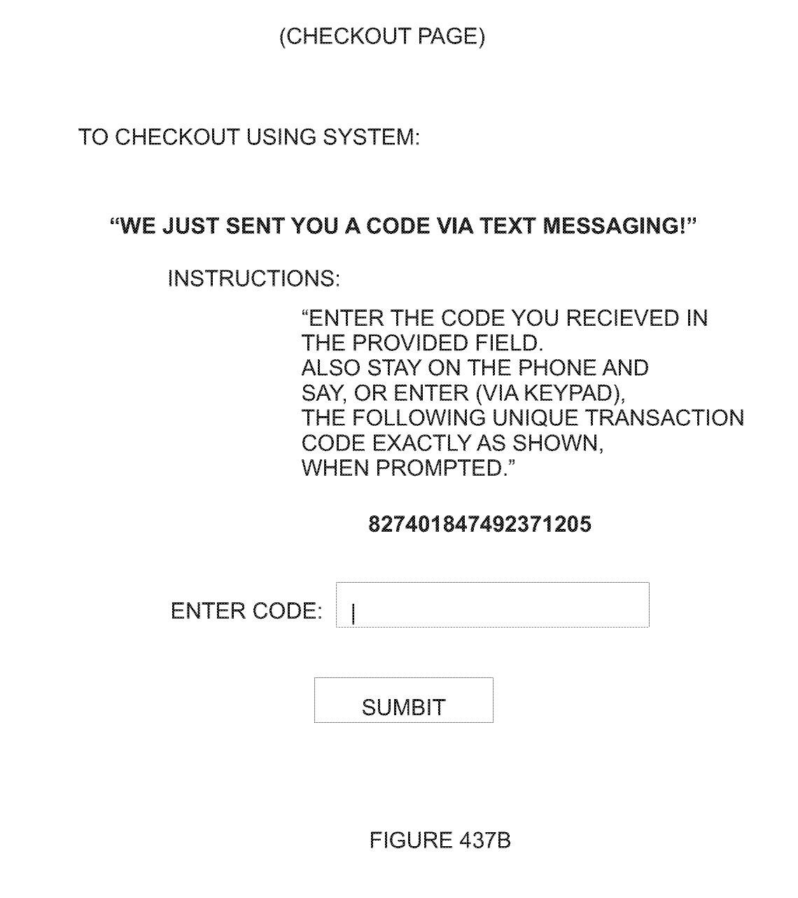

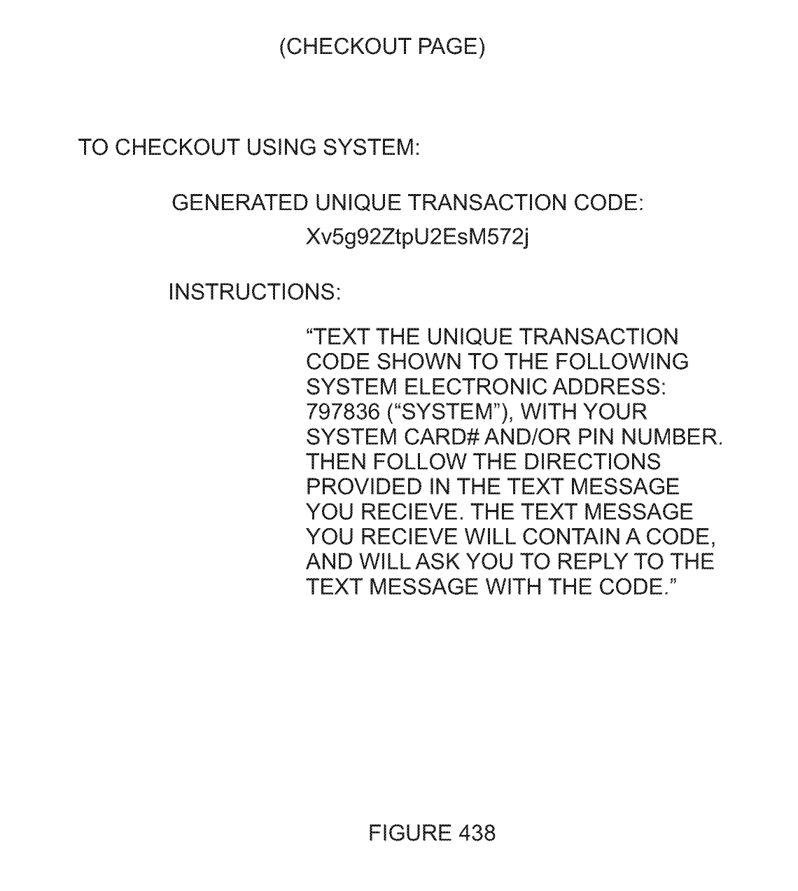

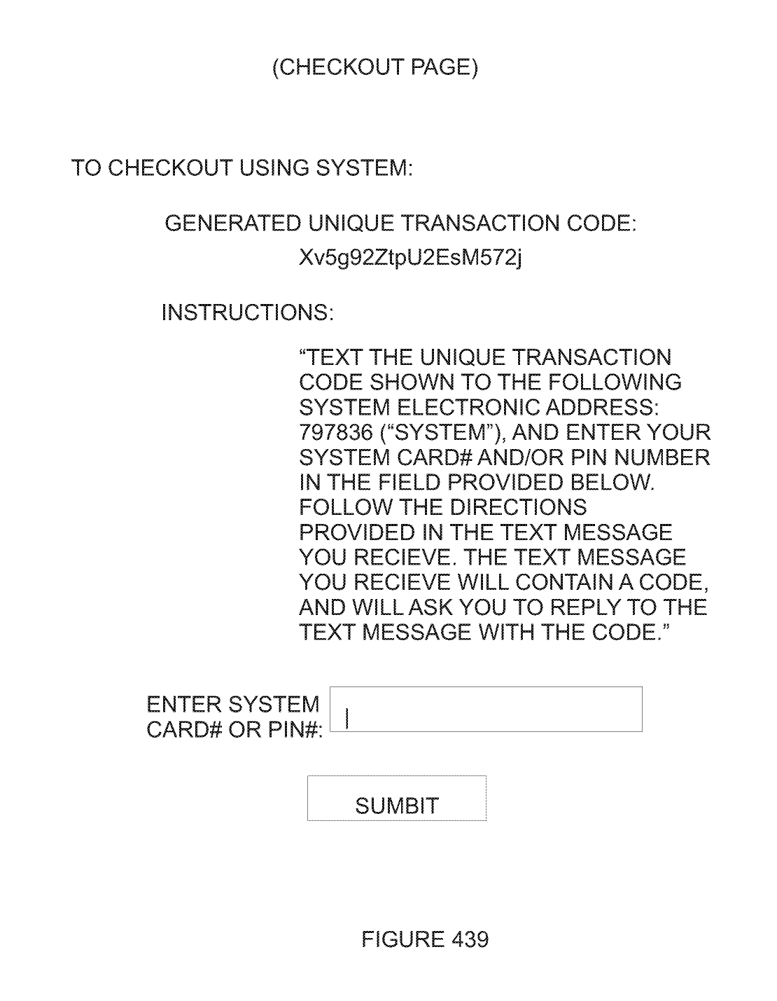

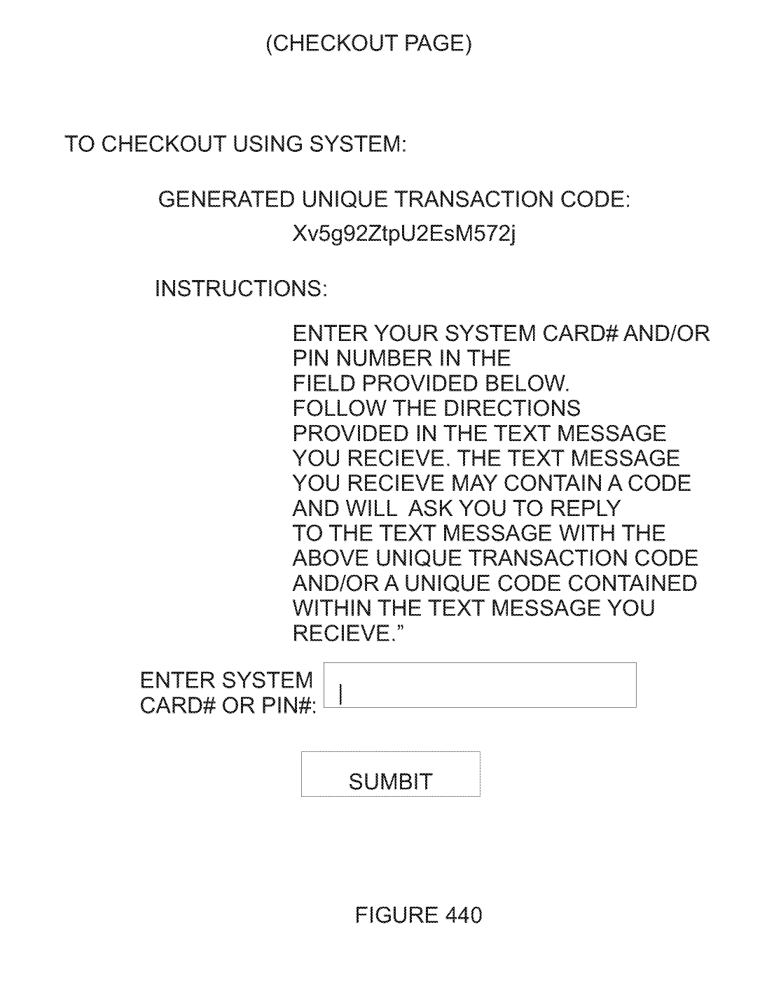

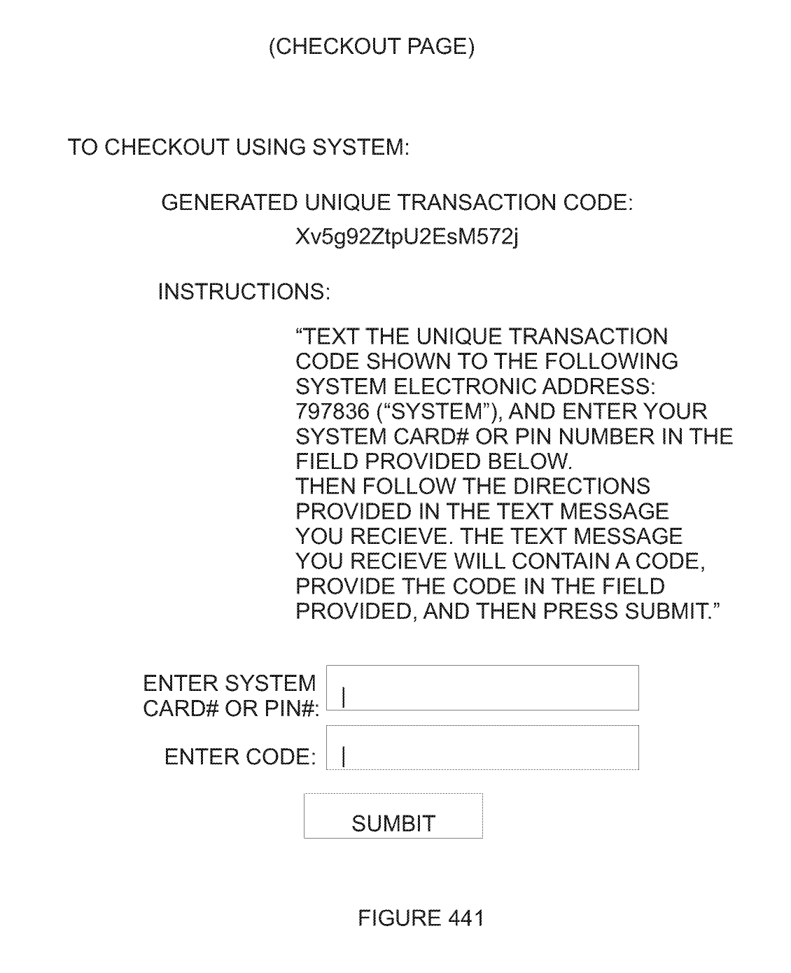

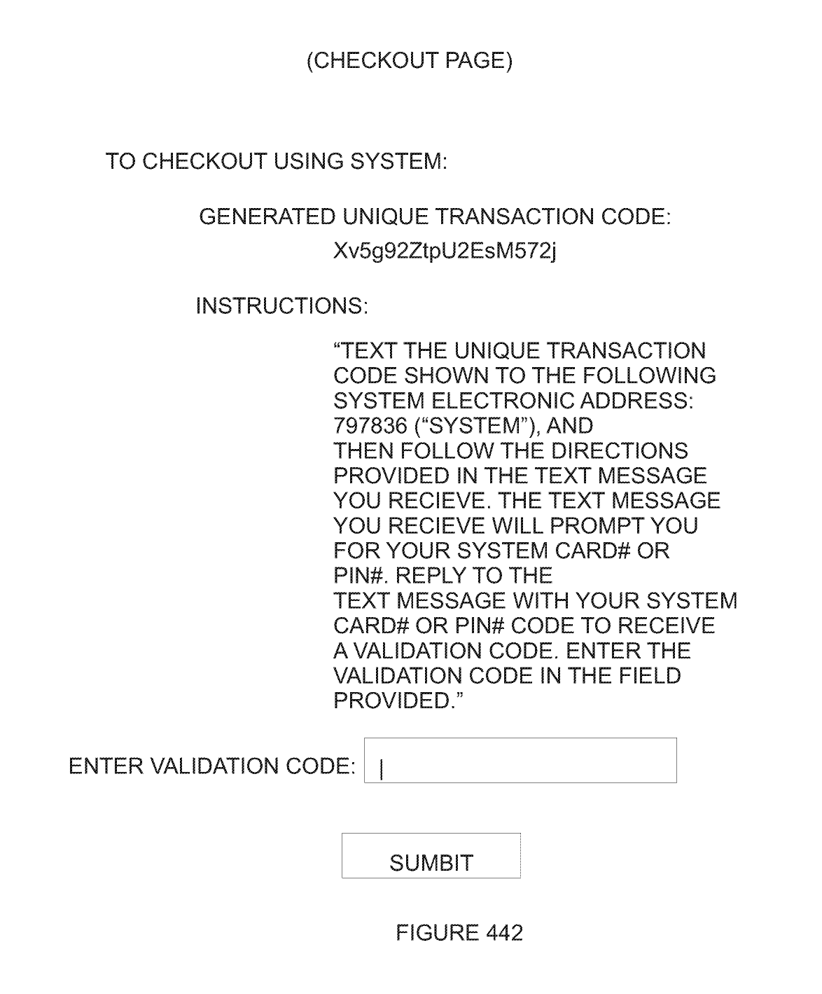

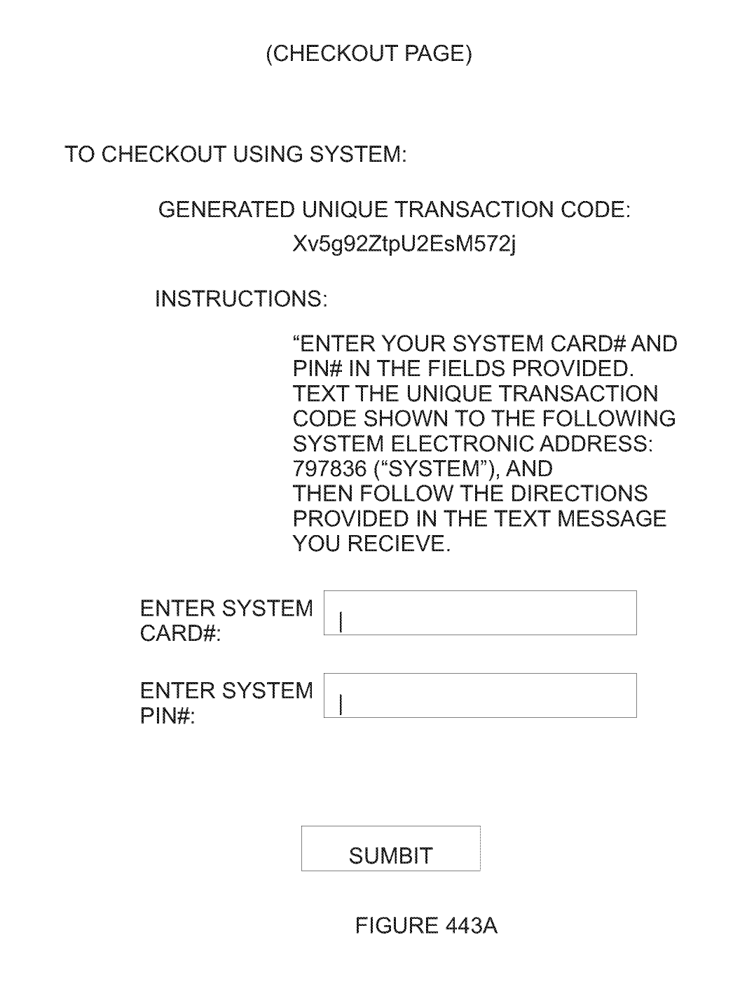

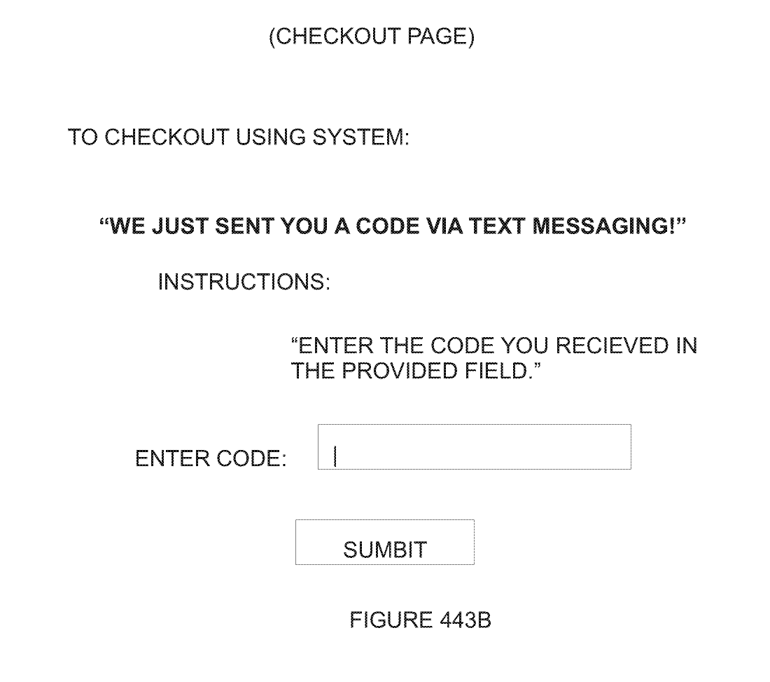

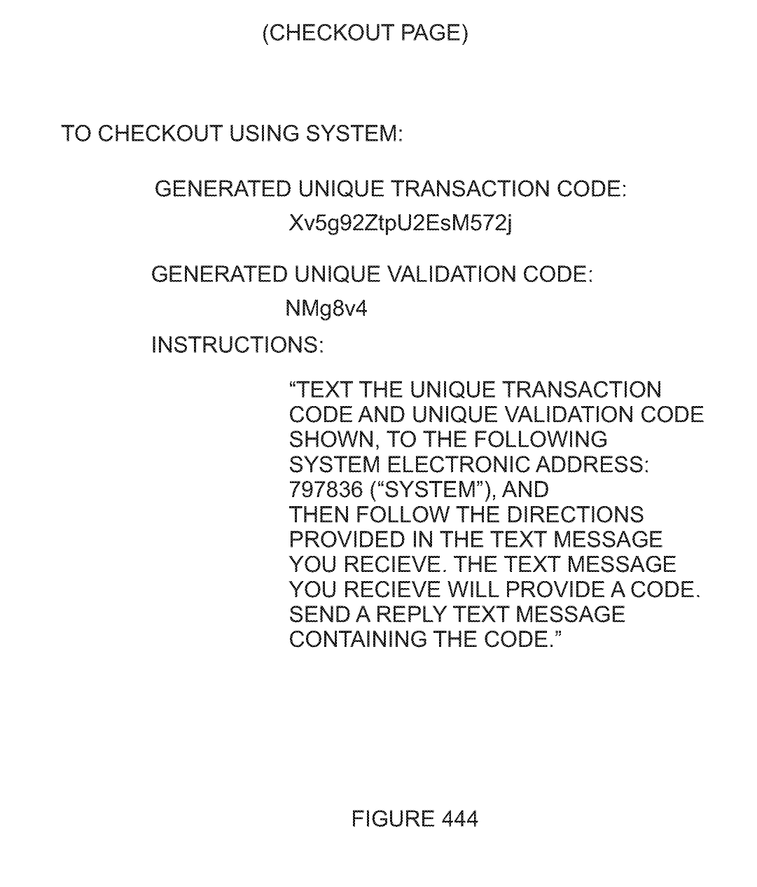

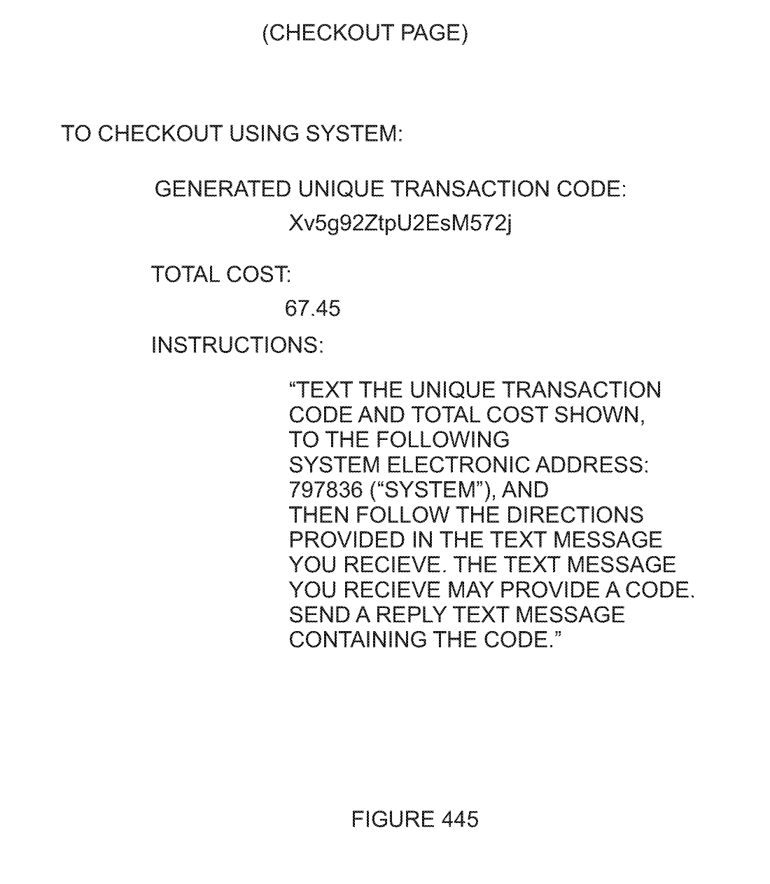

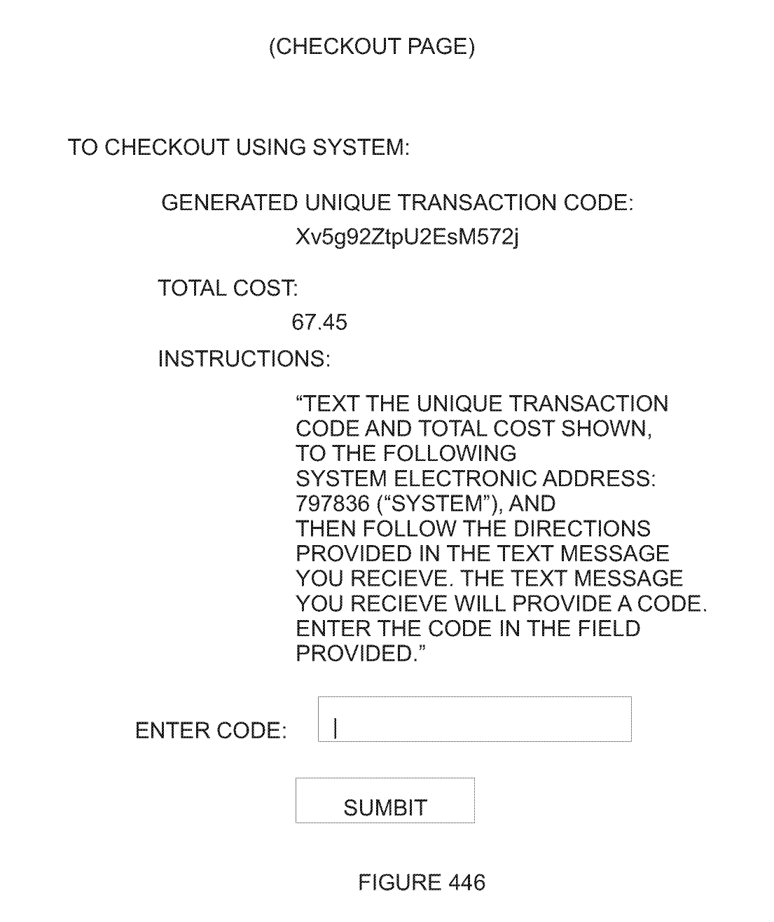

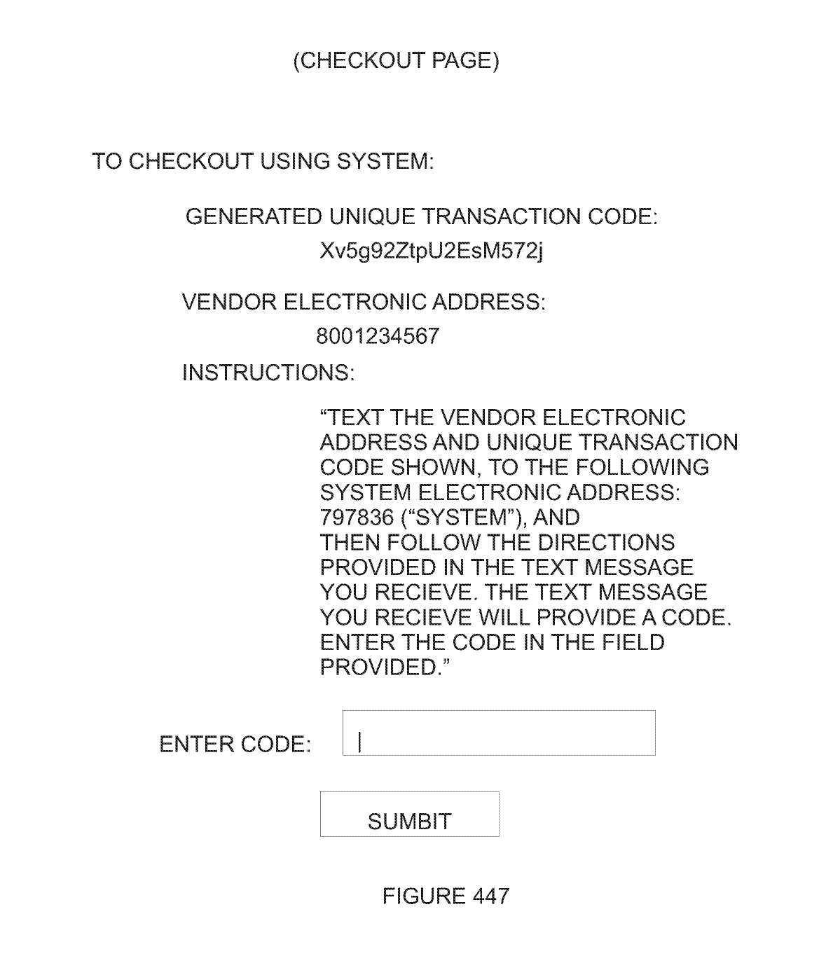

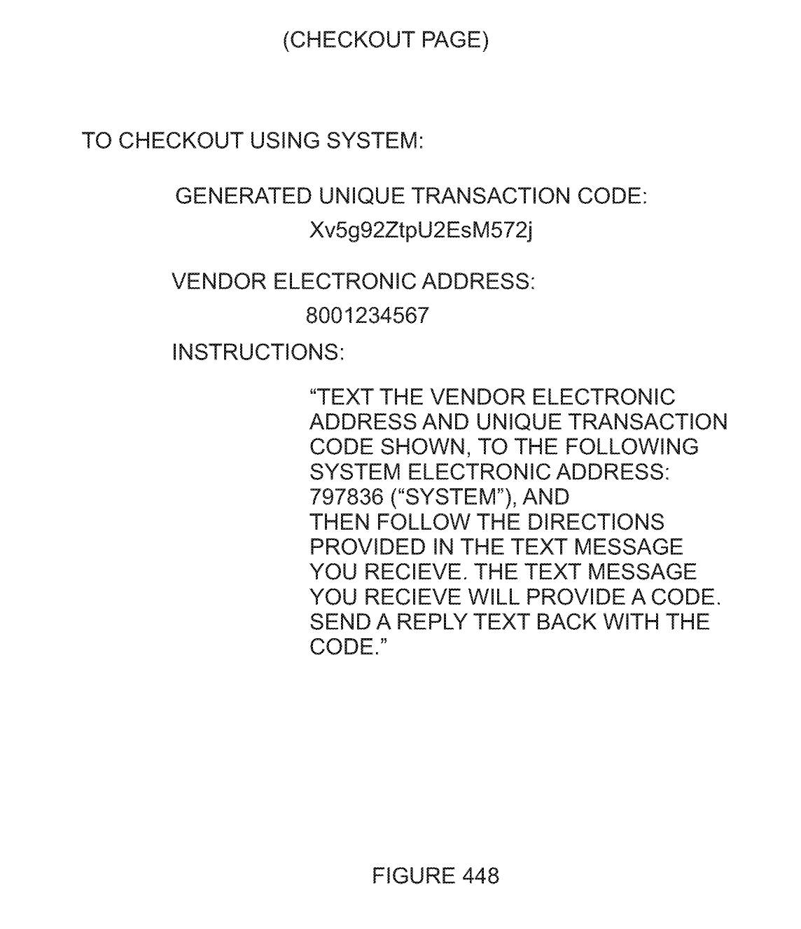

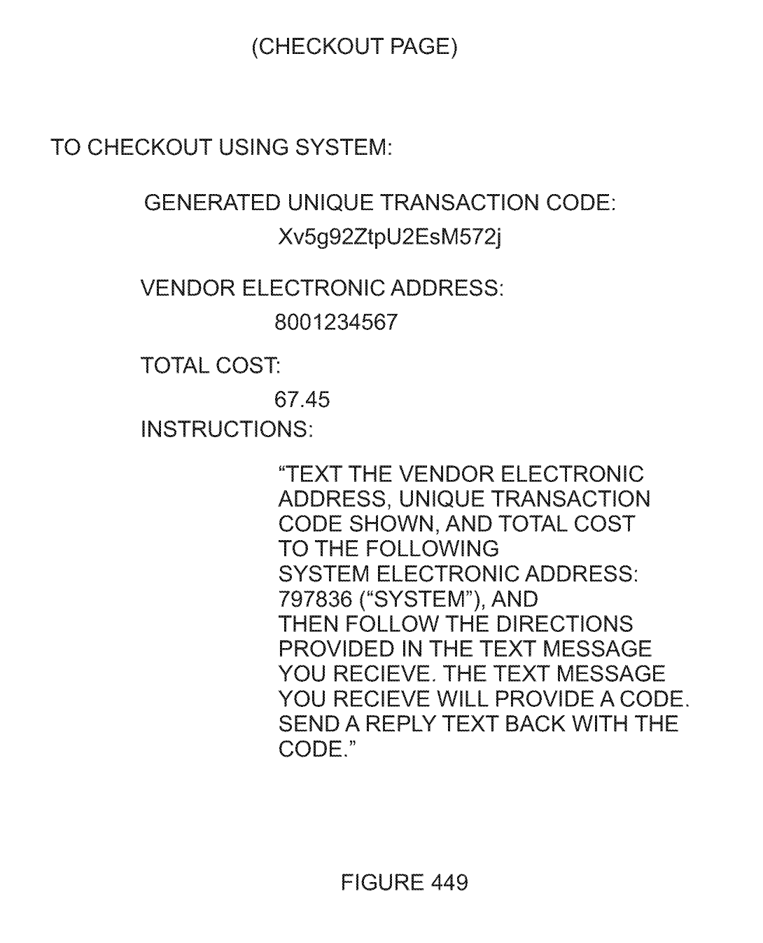

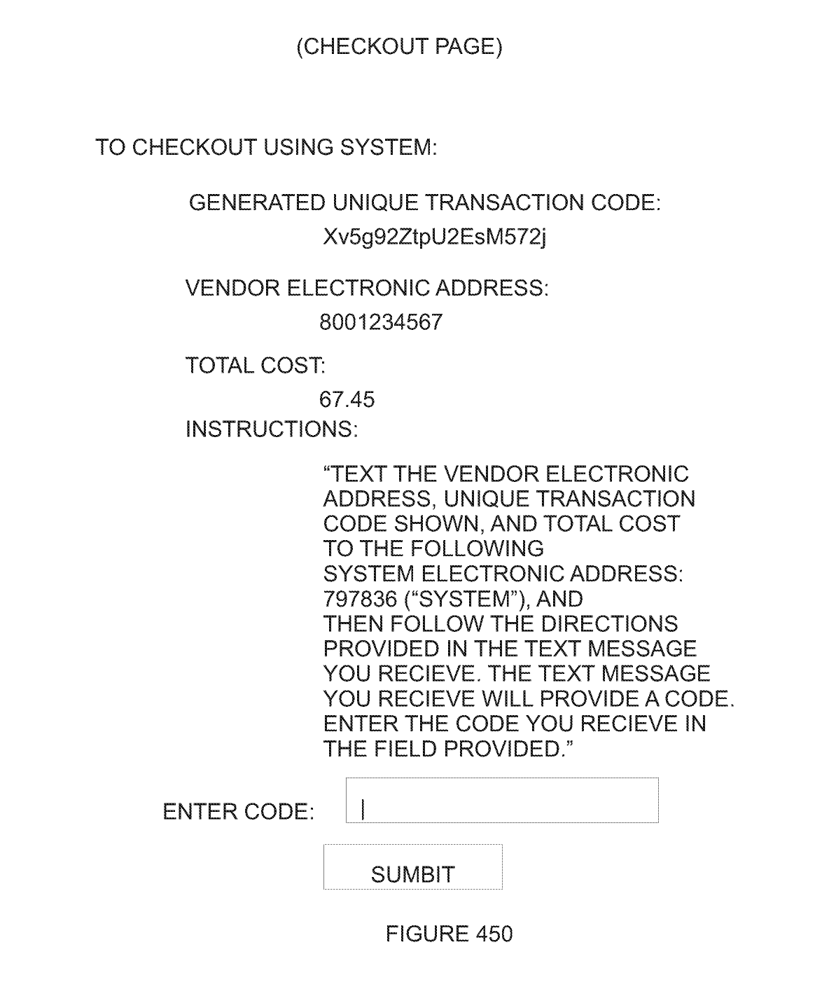

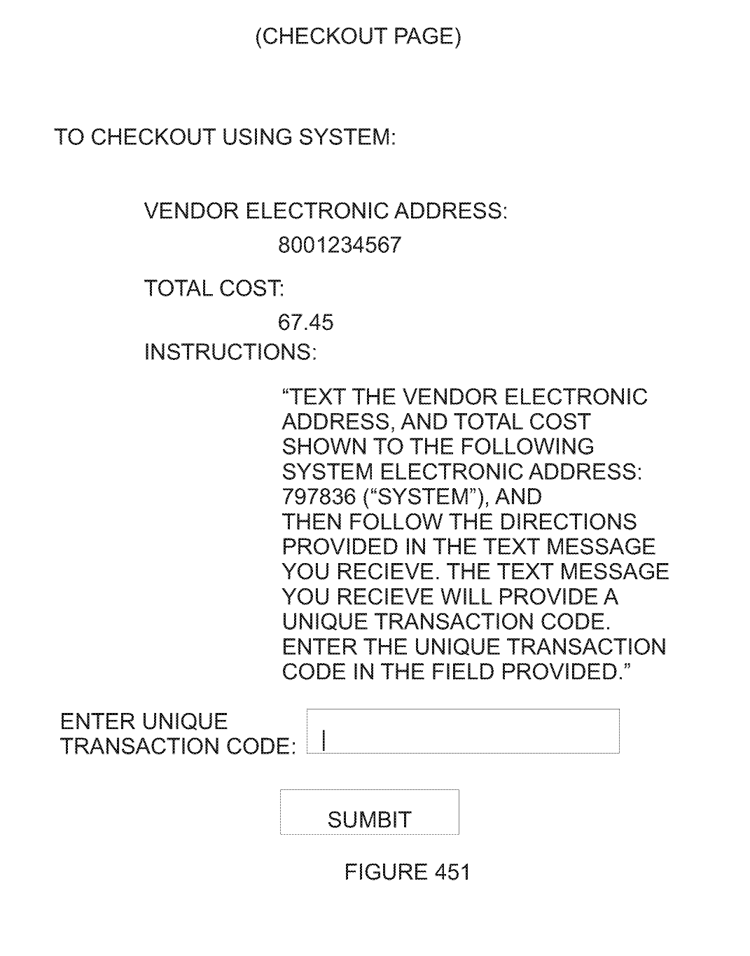

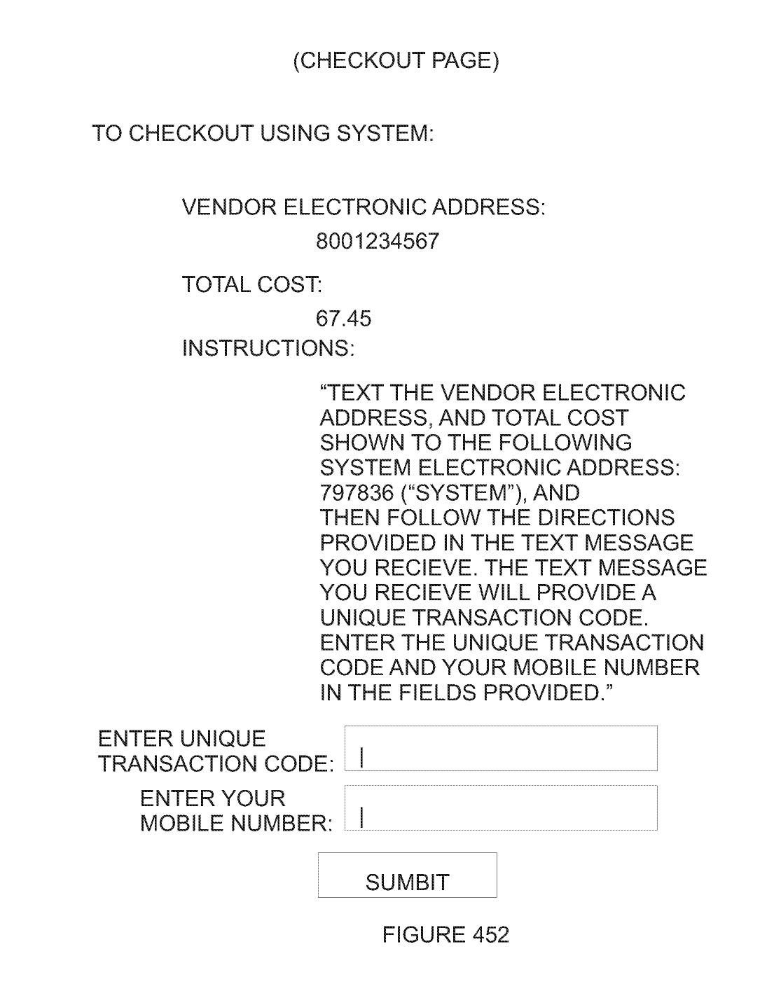

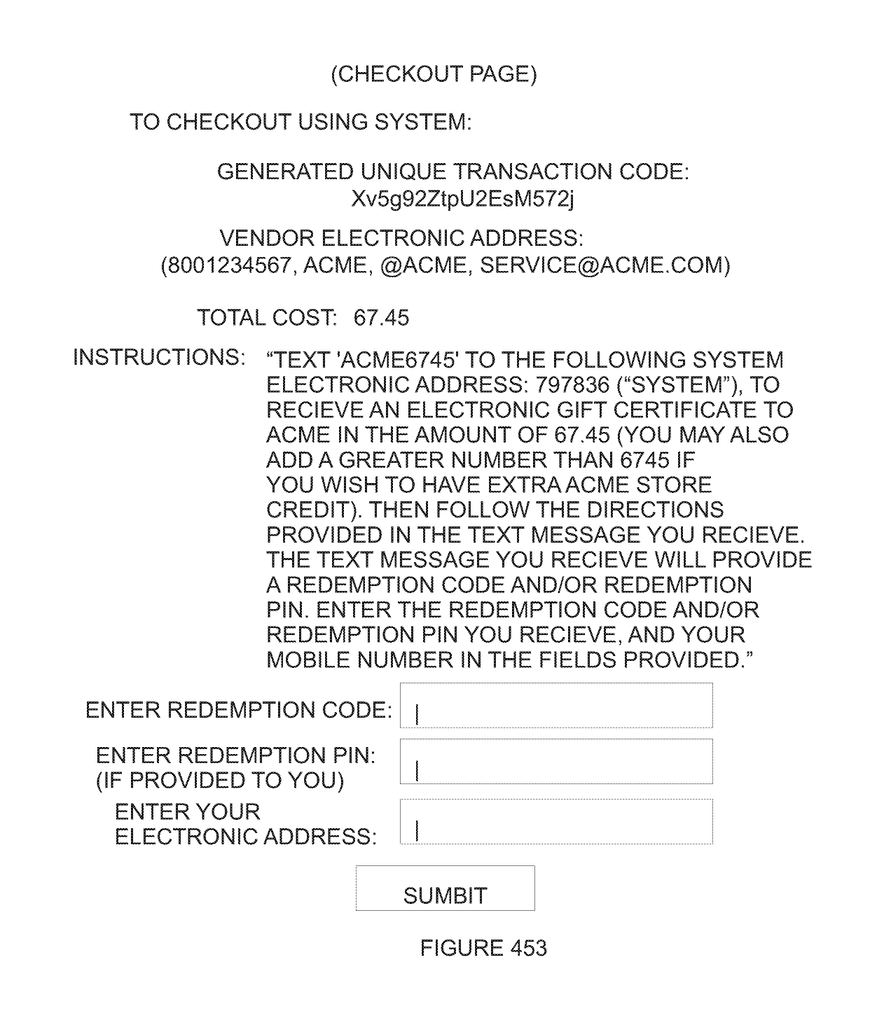

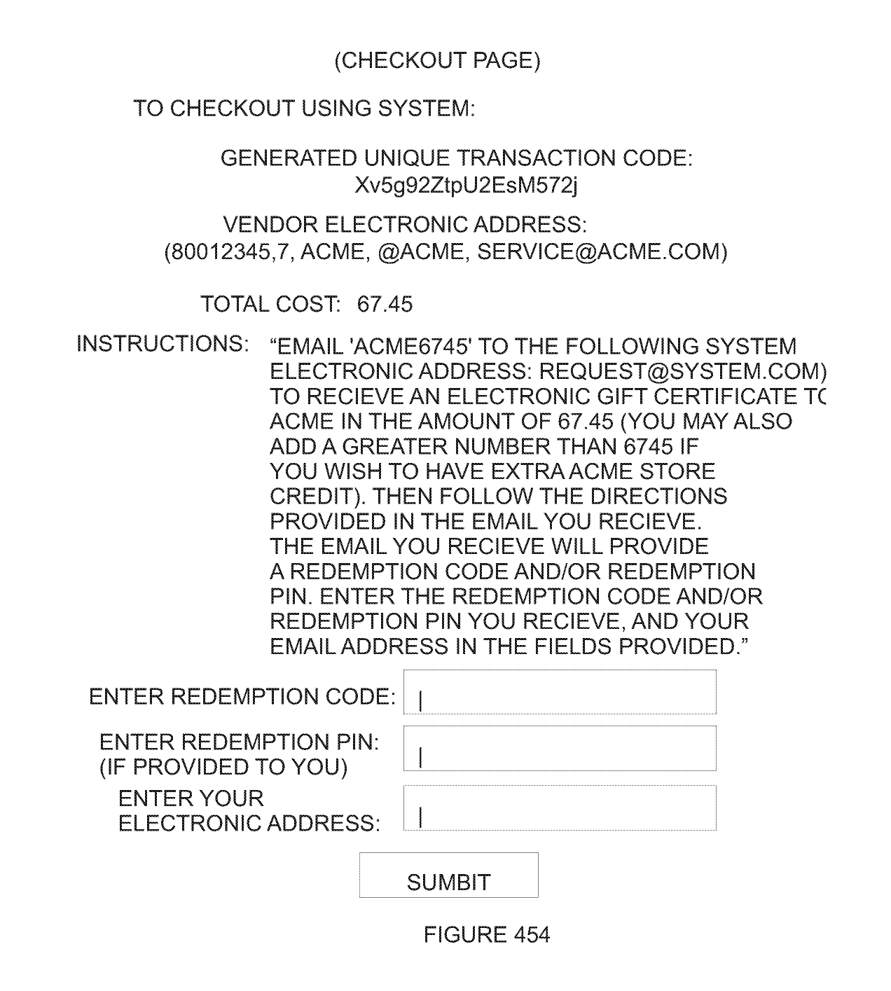

In some embodiments, the system, may, for security, immediately call the user back and ask for instructions. While not shown, in some embodiments, the system may, for security, prompt the user for one or more or portions of their user data 8 (e.g., one or more portions of one or more system card 19 numbers provided to their system card (e.g., “ShareCard” number), one or more or portions of one or more card PINs, one or more or portions of one or more card function codes, a personal system password, a previously requested and/or received one-time pass code, a real-time received one-time pass code (e.g., during the phone call), a previously requested and/or received semi-permanent pass code, a previously requested and/or received permanent pass code and/or the like), to verify their identity, without limitation. In this regard, only one phone call may be necessary to complete a system transaction, rather than a “call and then hang up” approach, without limitation. According to some embodiments, submissions may be made to the system using keypad entries (and/or voice-enabled speech entries). Upon receiving and processing the user entries provided as user inputs 4, one or more software components 147 of the system may access/populate/manipulate a one or more system-integrated databases, and may provide one or more system communications to a sending user and/or a recipient user, according to some working embodiments. It should be appreciated that the code, algorithms, and/or logical expressions could easily be modified to allow the delivery and receipt of funds or credits (inclusive of redemption information 64 such as information pertaining to one or more pre-paid or partially pre-paid items, products, goods, or services) to multiple recipients, for example, by allowing a user to enter multiple recipient phone numbers in the same sequence (e.g., same keypad entry), or in sequential sequences (e.g., in successive entries, according to system-user prompts within a navigable user interface 106). It should also be appreciated that code, algorithms, and/or logical expressions may be integrated with third party (i.e., non-system) databases, third party API's, third party software, third party websites, and/or third party platforms, without limitation. It should be understood that while phone numbers may be used as electronic addresses to identify recipients by their electronic addresses, other forms of electronic addresses may be provided to the system via such a phone-based platform. For example, other forms or means for delivery of redemption information 64 described herein, and/or other forms of electronic addresses may be utilized, without limitation (e.g., one or more recipient email addresses, one or more recipient physical addresses, one or more recipient social media 93 profile 130′ screen names/handles/userIDs/account numbers, combinations thereof, and the like, etc.). In some non-limiting embodiments, users may access a system website 127, may log into their own system portal (e.g., to access their system profile 130 information including preference 63 information), and may pre-populate “extensions” for frequent recipients. In this regard, sending users may, during a phone call to the system, be able to press or say a user extension (e.g., “1” for mom, “12” for Chuck, “8” for Joe the coworker, etc.) when prompted by the system hotline. This convenient feature may, in some instances, help to eliminate the need to re-enter, re-type, or repeat (e.g., verbally) recipient electronic addresses, for each time a transaction is made using a phone-based platform. It should be understood that extensions may comprise one or more email addresses, phone numbers, physical addresses, names, numbers, userIDs, screen names, profile names, or other information about recipients, without limitation. For example, in some embodiments, a user extension may be associated with a system “vanity” address which may comprise a user-defined “group” of individuals as may be appreciated by FIGS. 404-406. For example, this may be done by following a series of system prompts on a navigable menu-based user interface, selecting a prompt (e.g., by voice or keypad) associated with an option to define a recipient extension, selecting a prompt associated with an option to create a single recipient extension or a multiple recipient extension, selecting a prompt associated with an option to create the number of the extension to be defined (e.g., an option to define an extension number by saying or entering a predetermined number on the keypad), and providing (in the same instruction or in a series of successive instructions), one or more recipient addresses, using system syntax protocols, without limitation. In other words, in some embodiments, a user extension may be created and/or defined during a phone call to the system, instead a system website 127, for example, using a navigable menu provided through the user interface 106. A benefit of multiple-platform embodiments of the system, is that users may be enabled to conveniently perform various transactional functions and/or access profile 130 information, using a familiar or convenient platform.

In some embodiments, sending gifts, donations, money, and/or payments (e.g., online/electronic bills or paper bills), may be as simple as sending a text, an email, or a Tweet, without limitation. In some embodiments, the system and/or methods and apparatus thereof may provide the ability to buy, send, and/or deliver things in less than thirty characters, and in many instances, less than twenty characters (e.g., “@JaneDoe Redbox”, without limitation). In some embodiments, such abilities may be extended to less than 15 characters (e.g., “jim@aol.comPIE” as an instruction to purchase and send “jim@aol.com” pre-paid or discounted twelve-inch pizza with one or more participating entities 65 which may accept redemption information 64 pertaining to the system item code “PIE”, or “9014329284WM5” as an instruction to purchase and send “five dollars of Wal-Mart store gift credit” to a mobile device 96 having the mobile electronic address “+1(901)432-9284”), without limitation. In some embodiments, such abilities may be extended to less than 10 characters, for example using the system's “vanity” electronic address feature (e.g., “kids 5.00” as an instruction to send all electronic addresses stored in a user profile 130 associated with the user-created, user-defined vanity system address “kids”, funds or credits in an amount of “5.00” (e.g., $5, £5, ¥5), without limitation. According to some embodiments, no characters may be necessary, for example, when using voice command user inputs 4 to system components, such as kiosks 3, computing devices 95, mobile devices 96 (e.g., via a mobile application 147 or pre-installed voice-to-text software provided to a mobile device 96), without limitation. According to some embodiments, such activities may be performed without having to download a new application or visit a website. According to some embodiments, such activities may be performed without passwords to remember (e.g., wherein system components may provide one-time pass codes which may be used across different platforms or on the same platform that a one-time pass code is requested, without limitation). According to some embodiments, a new account may be created for an individual upon receipt of funds, credits, redemption information, and/or other system feature or component of the system; for example, in some embodiments, a communication may be made from the system to a user, wherein the communication may contain/present user account information, without the user creating an account or providing an instruction to the system, but rather someone other than the user making a communication to the system on behalf of the user, without limitation. For example, an individual who isn't yet a member of the system may have an account created for them, for example, by a friend, relative, co-worker, or contact of the individual making a transaction request to the system, without further action by the individual. According to some embodiments, a newly-created account may be utilized to perform system functions immediately. For example, a hypothetical scenario may comprise, without limitation, a first user purchasing redemption information 64 for a second user via a transaction request to the system; the system debiting the first user and sending new account information and first redemption information 64 to the second user; the second user receiving the new account information and the first redemption information 64; the second user re-gifting the first redemption information 64 to a third user; the system voiding the first redemption information, creating second redemption information 64 and new account information for the third user; the system sending the second redemption information 64 and new account information to the third user; the third user receiving the new account information and the second redemption information 64; the third user trading the second redemption information 64 for system credit; the system voiding the second redemption information 64 and crediting the third user's system account balance; the third user purchasing third redemption information for a fourth user using credit associated with the third user's system account balance; the system debiting the third user and sending new account information and third redemption information 64 to the fourth user; etc. . . . . In practice (e.g., using actually reduced to practice methods), all of the steps associated with the aforementioned hypothetical scenario may be able to be performed in less than a minute, without limitation.

In some embodiments, an individual may not need to go online (e.g., visit a system website 127) create a new user account. In some embodiments, an individual may receive one-time passwords when necessary, for example, by texting the number “1” (or other equivalent arbitrary command) to a system electronic address (e.g., a long code, short code, email address, or other electronic address via SMS). In some embodiments, an individual may receive one-time passwords when necessary, for by emailing the number “1” (or other equivalent arbitrary command) to a system electronic address (e.g., an email address such as “request@send1now.com”), without limitation. In some embodiments, an individual may receive one-time passwords when necessary, by emailing a password, pass code, or passphrase to a system electronic address (e.g., a system email address, or a phone number email address equivalent), without limitation. In some embodiments, an individual may receive one-time passwords when necessary, by calling a system electronic address (e.g., a system phone number), without limitation. In some preferred embodiments, if a user makes a phone call to send1's automated telephone number with their mobile phone and/or through a “connected car” (e.g., a vehicle command platform, hands-free platform (e.g., Bluetooth), or mobile command-based intelligent personal assistant software like SIRI, Cortana, Maluuba, Google Search, NissanConnect, etc.), one or more server-side system scripts 147 may be triggered (e.g., scripts which may involve a server-side programming language such as PHP/MySQL/Twilio API) which may instantly call the user back for security, wherein a user may provide voice instructions (e.g., audio input 7) as an input 4 to the system via the phone call; wherein the user may navigate and/or respond to an automated attendant to perform various transactions hands-free. In some embodiments, a user may merely need to call and hang up to perform a function using system components. Accordingly, according to some embodiments, a user may not have to store a password (e.g., in the cloud or in a database) that could be compromised. According to some embodiments, system features and/or method steps may comprise 2-step and/or multi-step authentication practices. In some embodiments, when request communications are made (e.g., via short code) to the system, the system may be configured in a manner such that the request communications (and/or system-delivered communications) may not significantly leave a cellular network. In some embodiments, a one-time verification code may not necessarily be required to make a transaction request to the system. In some embodiments, system security protocols may be at least as secure as Twitter (via SMS) or some mobile banking platforms (e.g., “push” messaging protocols). In some embodiments, if requests are made via SMS to a system electronic address (e.g., a system long code or short code), a verification code may need to accompany each transaction request to ensure against spoofing. In some embodiments, one or more verification codes may be sent before a transaction request, after a transaction request, and/or within the same transaction request (e.g., in the same electronic message), without limitation. System scripts 147 may be written to facilitate delivery of one or more one-time validation codes (e.g., via SMS, MMS, mobile messaging, voicemail, phone call, email, social media direct message (DM), and/or the like, combinations thereof, without limitation), at various times before, during, and/or after a transaction is made, for example, if a user sends one or more instructions (e.g., the number “1”) to a system electronic address (e.g., a system short code, long code, or social media screen name, without limitation). Such protocols and practices may, in some embodiments, discourage spoofing and/or mimicking of “from” electronic address information and may prevent the utilization of someone else's system credentials (e.g., someone else's phone number to make transactions using account information associated with the phone number), without limitation.

According to some embodiments, the processes for email-based transaction requests and for SMS/MMS/mobile messaging/social media-based system transactions may be similar and may utilize similar commands, syntax, formatting, ordering, sequences, arrangements, and/or the like, without limitation. In some preferred embodiments, a system-integrated database 129 may be simple, and may be shared between, and/or accessed by some, all, or any combination of the following communication platforms, without limitation: a phone call, an email, a text SMS/MMS/mobile message, a web form submission, a social media post, and/or a mobile application interaction with a user interface 106 (e.g., over WAP/Wi-Fi). In some embodiments, a first sending user 91 may use one “front-end” platform (e.g., email), to make a transaction request regarding one or more second recipient users, and may be able to complete a transaction associated with the transaction request, via system components 118, 128, 129, 147, using another “back-end” platform (e.g., SMS, social media platform, or voicemail) used by the one or more second recipient users 92. It should be understood, that in some embodiments, a front-end platform used to request a transaction may be the same or different as a back-end platform used to complete the requested transaction, without limitation.

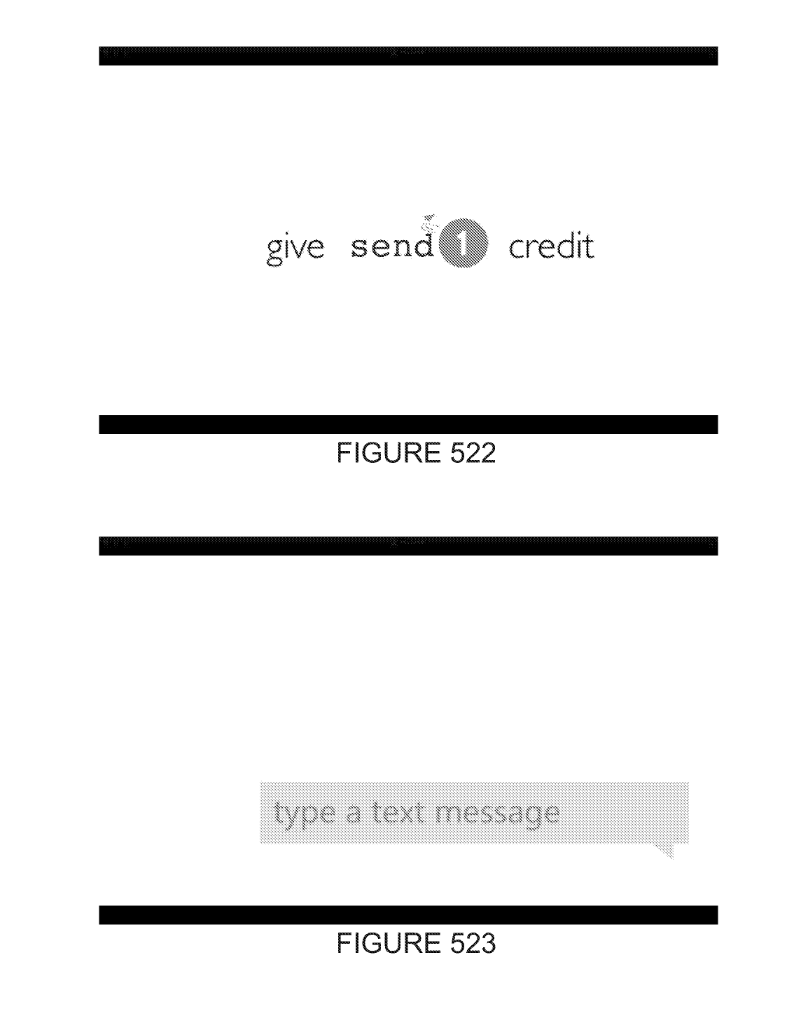

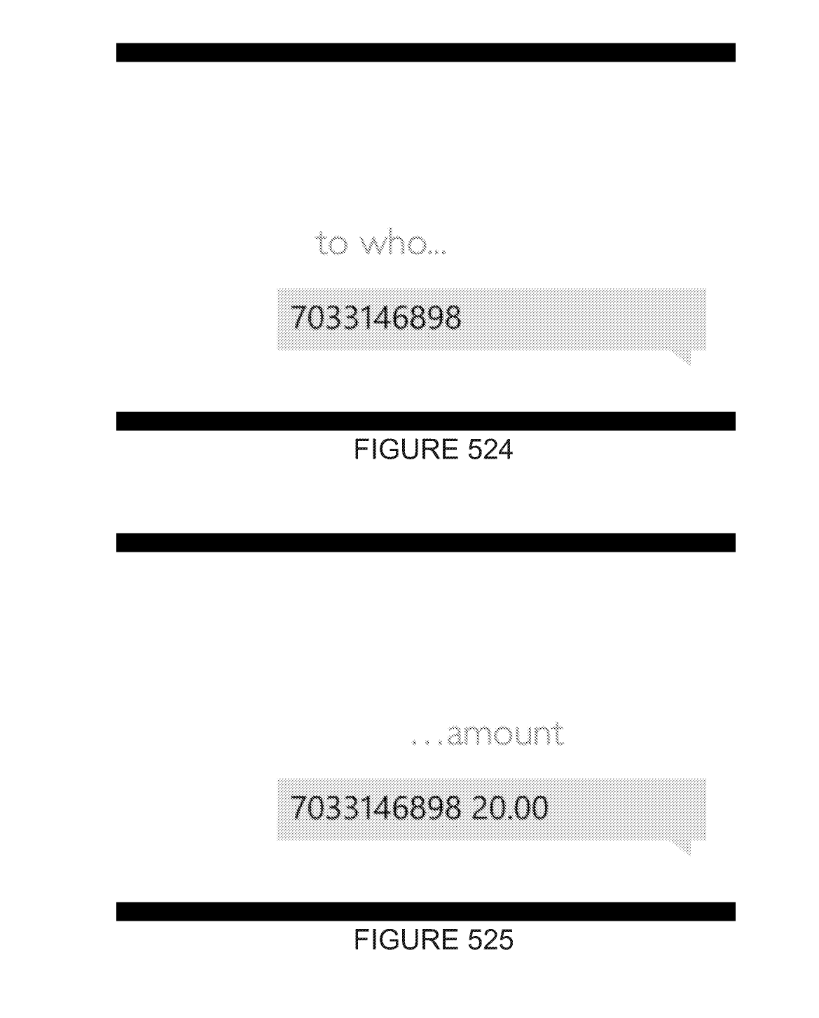

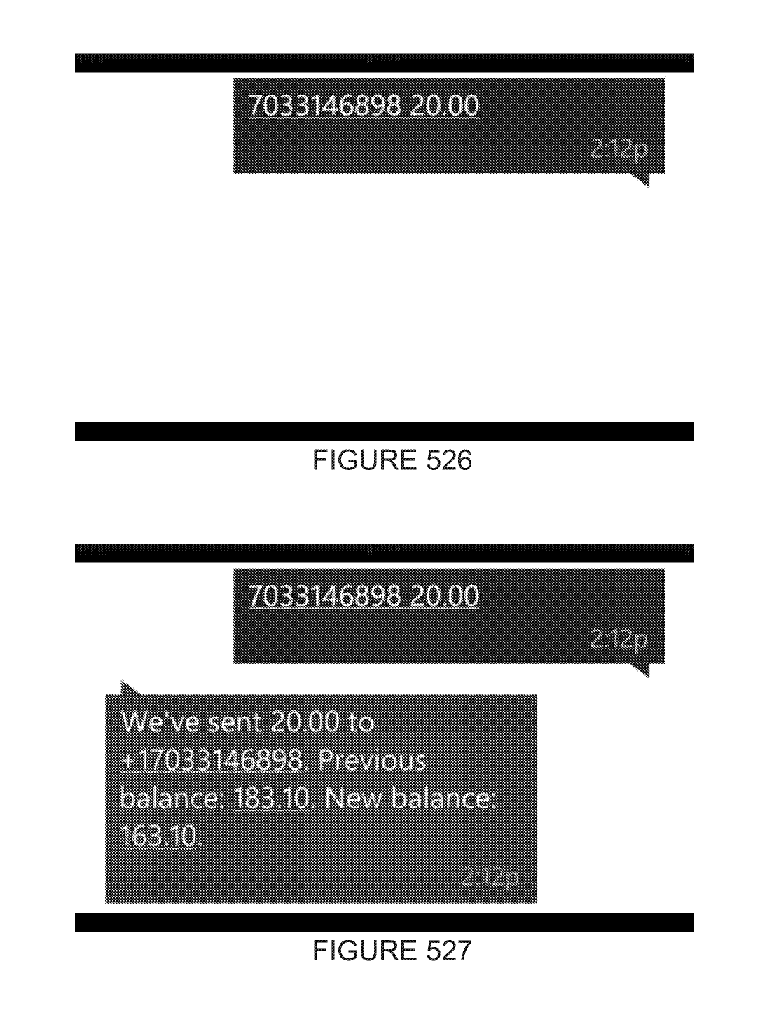

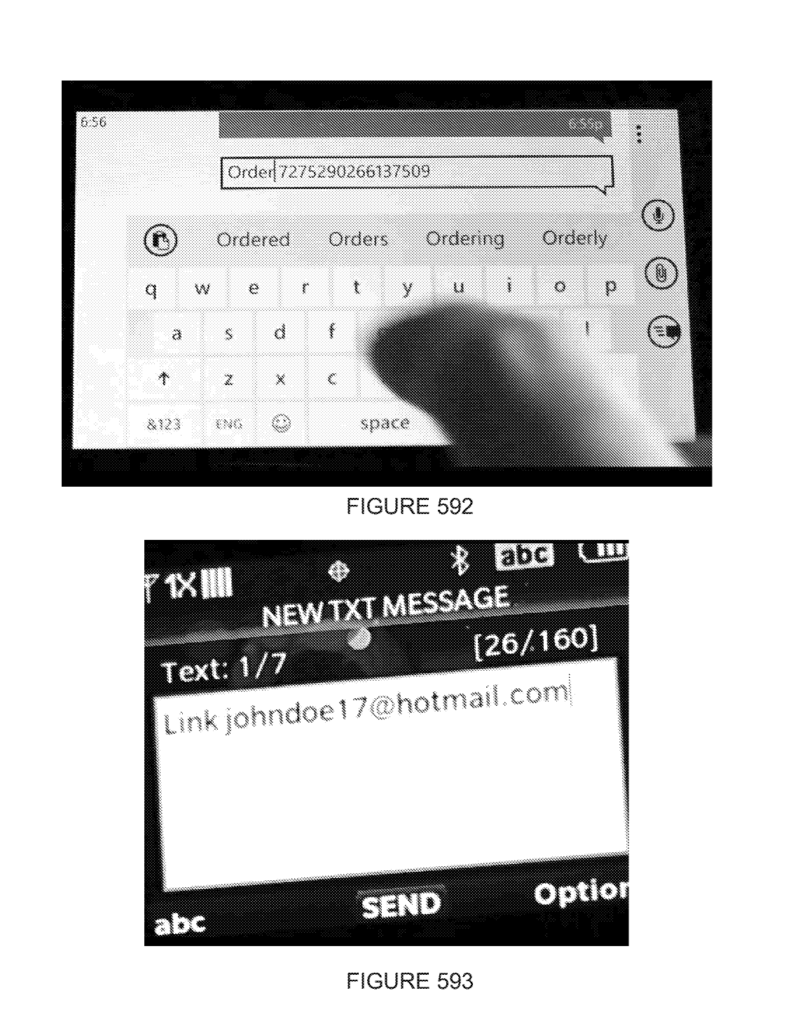

In some non-limiting embodiments, nothing more than a user's electronic address (e.g., a user's phone number) and a form of payment (e.g., payment data 10) may be required. In some non-limiting embodiments, users may not necessarily need to provide their credit card or banking info. For example, in some embodiments, a user may pay cash to purchase a card 19 at a physical location 2, such as a participating entity 65 location 2, and then the user may activate the card 19 to begin using electronic funds associated with the purchased card 19, electronically. In some non-limiting embodiments, the user may also pay cash to add funds to the card 19. In some non-limiting embodiments, a user may pay cash at a participating entity 65 location to receive system credit to an electronic address; wherein the system credit may be delivered by the participating entity 65 using a mobile device 96 or computing device 95 (e.g., a P-O-S payment terminal), without limitation. In some non-limiting embodiments, it may not be necessary to store “sensitive” personal information (e.g., user data 8) in the cloud. In some embodiments, unlike conventional money transfer platforms, recipients may not be required to sign up, create an account themselves, and/or be required to use proprietary platform software. In some non-limiting embodiments, a user may not necessarily need to follow a link in an email to sign up via a web page. In some non-limiting embodiments, a recipient user may not be required to create a user account online in order to utilize received funds and/or credits. In some non-limiting embodiments, a user may not necessarily be required to create a new user password or user ID. In some non-limiting embodiments, a user may not necessarily be required to provide social security information, provide bank account information, provide debit/credit card number information, and/or provide other “sensitive” personal information in order to benefit from the platform (e.g., in some embodiments, all that may be necessary is an electronic address of the user). However, in some more expansive embodiments, certain features like an “order” feature, which may allow users to have items delivered to them or to one or more designated recipients, may be utilized by a user, at their own discretion; wherein a user may provide their physical address information (and/or recipient physical address information) to a system database 129, to have items delivered to them via a system platform, without limitation. In some embodiments, location data (e.g., a current location of a mobile device 96 possessing an electronic address) may be utilized to determine a delivery location (e.g., to complete an “order” transaction request to the system), without limitation. Physical address information may be received, stored in a database, and/or used by system components to process, verify, authenticate, and complete transactions. For example, in some embodiments, a step of providing physical address information may comprise the user texting and/or emailing an “add” or “link” command (or an equivalent arbitrary system-recognized command suggesting the function of linking a physical address to their account number 48, card 19 number(s), electronic address information, profile 130, etc.), to a system electronic address, without limitation; wherein the physical address information may be provided in the electronic communication comprising the “add” or “link” command, or wherein the physical address information may be provided in a subsequent electronic communication in response to a reply communication to the system after the system receives the “add” or “link” command or the like. In some embodiments, an “add” or “link” command (or the like) may be used in a similar fashion; wherein a user may provide electronic address information, such as one or more electronic addresses (e.g., phone number and/or email address information). For example, in some non-limiting embodiments, a user may provide the word “add” or “link” (or the like) and then type their electronic address information in a text-containing electronic message and send it to a system address (e.g., send via a text or email), without limitation. In some embodiments, an electronic communication comprising an “add” or “link” command/instruction (or the like) may be sent to the system by a user, and the system may reply with a prompt communication (e.g., “Please say/type/enter your electronic address”), and the user may reply to the prompt communication with a reply communication comprising the electronic address information, without limitation. In some embodiments, the physical address information may be scrubbed, cleansed, parsed, and/or validated as necessary by system components, such as system software 147 (e.g., using system scripts and/or third party address verification software (e.g., APIs or scripts), such as Google Maps software, Bing Maps software, and/or US Postal Service address verification software suitable for online commerce platforms). In some embodiments, one or more received physical addresses may be used instantaneously and/or in real-time to perform a one-time transaction. In some embodiments, one or more received physical addresses may be stored in a system database 129, for example, in one or more user profiles 130 (e.g., a first user-provided physical address may be stored in a database table adjacent (e.g., in the row or table) to the user's electronic address information (e.g., the user's mobile number, social media handle, or email address) which may be associated with their system account 48 information, redemption information 64, system credit balance, and/or the like, without limitation. In some embodiments, using the “order” feature (e.g., in an electronic communication to the system using one or more system components) to redeem redemption information 64 (e.g., a redemption code) via physical delivery (e.g., via home delivery, office delivery, or current location delivery via location data), and one or more system components receiving an “order” command or the like as an input 4 from a user 92 possessing redemption information 64, may trigger a server-side script to send an electronic communication to the participating entity 65 (e.g., via a server 136 of the participating entity 65) which may be associated with the redemption information 64 (e.g., redemption code) to be used as part of the physical delivery (e.g., wherein when physical items, products, goods, or services associated with the redemption information 64 are to be delivered), without limitation. It should be appreciated that in some non-limiting embodiments, an “order” command or the like, may be used in conjunction with a unique code (e.g., a system-recognized item code, UPC code, hashtag, or the like), in an electronic communication to the system, instead of in conjunction with redemption information 64, without limitation (e.g., the string “order BigBurger1632” may be provided in an electronic message communication from a user to the system, wherein “order” may be indicative of a function pertaining to “paying for” and/or “deliver to”, and/or wherein the portion of the string “1632” may be indicative of: a predetermined type (e.g., type of value meal), a location 2 of a participating entity 65 (e.g., a local store), and/or a user-defined preparation preference or standard such as “extra pickles, no mayo, no condiments”, without limitation). In some embodiments an electronic communication sent from the system to the participating entity 65 may comprise physical address information, an instruction to deliver to one or more physical addresses associated with the physical address information, information pertaining to one or more items, products, goods, and/or services to be delivered, a notification that the respective one or more items, products, goods, and/or services have been paid for using the system, and/or transaction information such as purchase data 9, without limitation. In some embodiments upon a participating entity 65 receiving an electronic communication from the system, the participating entity 65 may call the respective user making an order request (e.g., if the order request was made using a system phone number electronic address), without limitation. In some embodiments upon a participating entity 65 receiving an electronic communication from the system, the participating entity 65 may email the respective user making an order request (e.g., if the order request was made to a system email electronic address), without limitation. In some embodiments upon a participating entity 65 receiving an electronic communication from the system, the participating entity 65 may text (e.g., via SMS/MMS/mobile messaging app) the respective user making an order request (e.g., if the order request was made to a system via SMS/MMS/mobile messaging), without limitation. In some embodiments upon a participating entity 65 receiving an electronic communication from the system, the participating entity 65 may send a social media post (e.g., via a direct message (DM) of a social media 93 platform/website) to the respective user making an order request (e.g., if the order request was made to the system via a social media platform), without limitation. In some embodiments, if a user making an “order” request communication to the system comprises multiple linked electronic addresses, the electronic communication delivered to a respective participating entity 65 may comprise all of the electronic addresses, whereupon receipt of the electronic communication, the participating entity 65 may send an electronic communication to each of the electronic addresses, without limitation. In some embodiments, an electronic communication sent to a user making an order request may comprise instructions on how to complete the transaction, without limitation. For example, if redeeming redemption 64 for a free sub or pizza from a participating entity 65 that delivers (e.g., Domino's, Papa John's, Pizza Hut, Jimmy John's, etc.), the participating entity 65 may call the respective requesting user making an “order” request communication, the phone call asking for details (e.g., preferred preparation ingredients, toppings, etc.), without limitation, in particular, if the redemption information 64 and/or unique code provided in conjunction with the “order” request or the like does not specify details and/or particulars of the item(s)/product(s)/good(s)/service(s) to be delivered. In some non-limiting embodiments, a participating entity 65 may request address information and/or other delivery particulars which may be necessary to complete the transaction and delivery outputs 5. According to some non-limiting embodiments, a participating entity 65 may provide expected wait times (e.g., via any platform or communications protocol mentioned herein), without limitation. In some embodiments, a requesting user that places an order via system components (e.g., a system “order” request communication to the system) may, in some embodiments, decide to tip a driver who may be performing a delivery function. In this regard, a tip (and/or tax, fees, surcharges, and/or the like) may automatically be calculated from one or more system profile 130 preferences 63 or other system-integrated database 129, 135, 137, 138 information, and/or may be automatically deducted from the requesting user, via system software 147, without limitation. In some embodiments, a user making an order request may, in some instances, wish to tip a driver separate from the “order” transaction, for example, via a subsequent system credit transfer request (e.g., by entering/providing the driver's electronic address, such as a driver mobile number/email address/social media handle, and an amount of system credit to tip, as may be appreciated by FIGS. 522-527). In this regard, a delivery person may set up a system vanity address (e.g., “pizzaguy1347”), and may provide the vanity address to a user who performed an “order” request, upon delivery. Alternatively, a delivery person may provide personal electronic address information (e.g., a social media screen name, an email address, a phone number, and/or the like) to a user who performed an “order” request, upon delivery, in order for the user to perform a transaction request to the system regarding a credit transfer to the delivery person, without limitation. One exemplary non-limiting embodiment of an “order” request communication is shown in FIG. 592, wherein the shown request is being performed via a SMS/mobile messaging protocol to a system short code, and wherein “7275290266137509” being shown is representative of pre-paid redemption information 64 (e.g., in the form of a numerical redemption code) which may have been received from another user or previously purchased by the user, without limitation.

According to some embodiments, using/redeeming redemption information 64 may be as simple as showing a mobile device display, for example, a mobile device 96 comprising a screen which displays (e.g., visually), and/or emits (e.g., audibly), redemption information 64 (e.g., in text format, machine readable format, sound wave format, combinations thereof, and/or the like, without limitation).

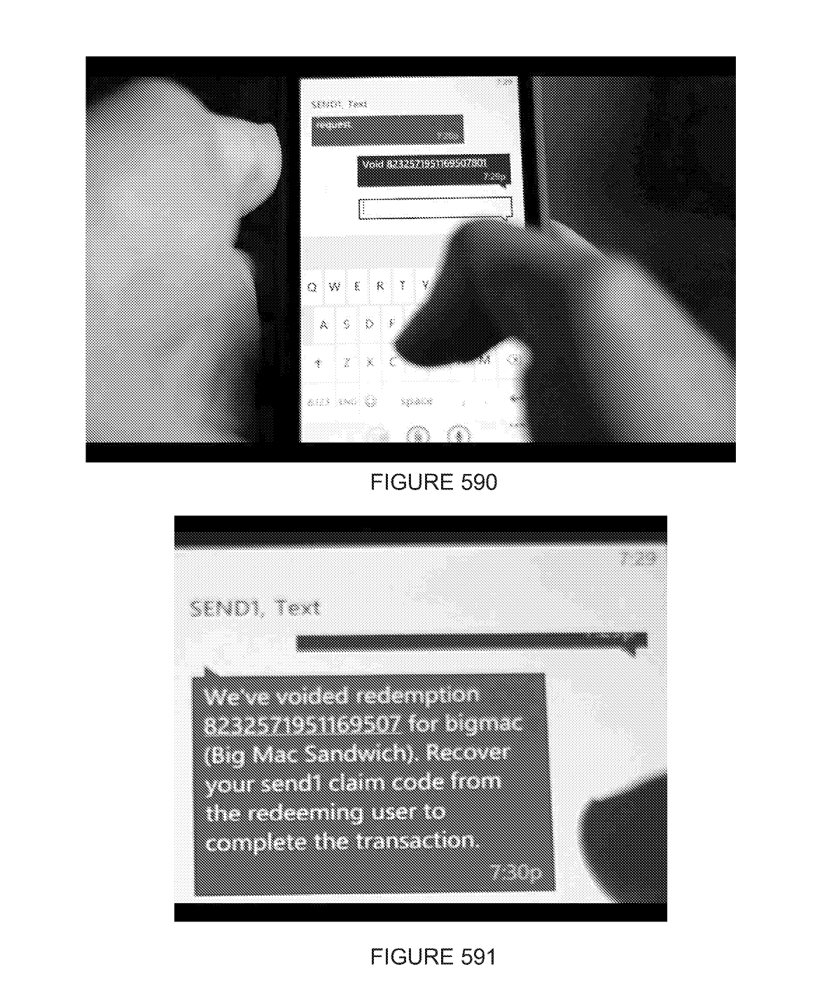

For example, in some embodiments, a user may simply show their mobile device 96 (e.g., cell phone cell phone screen displaying redemption information 64) to a participating entity (e.g., a respective merchant configured to provide the item(s)/product(s)/good(s)/service(s) associated with the redemption information 64, in exchange for the redemption information 64). In some embodiments, a user may simply provide his/her redemption information 64 (e.g., text-based, machine-readable-based, image data 6-based, and/or audio-data-based redemption code information) at checkout. In some embodiments, a checkout venue/location 2 may comprise a physical (e.g., brick-and-mortar location). In some embodiments, a checkout venue/location 2 may comprise online checkout, such as an online website of a participating entity 65. For example, in some embodiments, redemption information 64 (e.g., a redemption code comprising one or more strings) may be provided to a “promo code” box on a web page of a participating entity 65, for example, to a “promo code” box provided to a checkout page, as may be appreciated from the appended figures, without limitation. In some simplistic embodiments, redemption information 64 may comprise one or more redemption codes, redemption PINs, and/or claim codes. The one or more redemption codes, redemption PINs, and/or claim codes may comprise, without limitation, any number and/or combinations of uppercase letters, lowercase letters, numbers, symbols, and/or characters. In some embodiments, redemption codes may comprise one or more associated PINs (for example, one or more associated PINs which are sent by system components to a respective user receiving the redemption codes), wherein the one or more associated PINs may be sent by system components separately from communications containing the redemption codes; and/or wherein the one or more associated PINs may be sent by system components with the redemption codes (e.g., in the same electronic communication(s)). In some embodiments, the one or more associated PINs may be utilized with components of the system and various method steps, for improved security, validation, and/or authentication purposes, without limitation. In some embodiments, participating entities 64 (e.g., merchants) may require portions of electronic addresses and/or entire electronic addresses (e.g., all portions or some portions of a user's email address, phone number, social media profile ID/address/screen name, combinations thereof, and/or the like, without limitation) of a user, for example, in order to verify that the user may be the rightful owner/“bona-fide” recipient of the respective redemption information 64 (e.g., the rightful owner/“bona-fide” recipient of a redemption code and/or redemption PIN), without limitation. Existing infrastructures, such as online/web-based “promo code” entry fields, and/or new system-proprietary fields (e.g., one or more system-specific data entry fields) may be provided to websites using system software 147 (e.g., system plug-ins, add-ons, browser apps, widgets, API's, code, software, and/or the like), without limitation. According to some non-limiting embodiments, representatives of participating entities 65 (e.g., a merchant employee) may use a system built-in “void” command infrastructure or the like, for example, if a participating entity 65 doesn't have system-integrated payment terminal hardware/software 147. This may be appreciated from FIGS. 589-591, which show various steps of a user (e.g., a participating entity 65 employee using a mobile device 96 configured with an SMS/MMS/mobile messaging user interface 106 addressed to a system short code electronic address) receiving redemption information 64 (e.g., in the form of a redemption code string “8232571951169507”), wherein incidental information (e.g., a redeeming user's 92 area code “801”) is provided after the redemption information 64 as an added security measure (FIGS. 589 and 590), without limitation. In some embodiments, a participating entity 65 may process received redemption codes internally, for example, without communications to the system (e.g., this may be done by the participating entity 65 entering user-provided redemption information 64 into a respective participating entity database 137 on a respective participating entity server 136, for example, via a participating entity payment terminal having a user interface 106 which may be utilized to enter one or more user-provided redemption codes, without limitation). In some embodiments, redemption information 64 which may be stored by the participating entity 65 (e.g., on a respective participating entity database 137), may be used in a claim to the system, for example, to apply for reimbursement from the system in a convenient manner (e.g. at predetermined time intervals, as the participating entity 65 sees fit), without limitation.

In some non-limiting embodiments, the system may provide a simple, yet versatile electronic commerce platform. For example, in some embodiments, the inventive technology described herein may allow a user to purchase, gift, order, receive, donate, sign up for events, recommend, like, add to a wish list or shopping list, and/or send everyday items, products, goods, and/or services, including, but not limited to, redemption information 64, universal system-based gift credit, participating entity-accepted digital store credit, other forms of payment data 10, various combinations thereof, and/or the like without limitation; for example, with a single text message, and/or with one or more text-based electronic communication messages, without limitation.

In some preferred embodiments, a short code may be used as a system electronic address, for example, for SMS/MMS/mobile messaging application protocols; however, a long code may be equally employed as a suitable electronic address (e.g., for VoIP protocols, phone calls, voicemail delivery, combinations thereof, and/or the like), without limitation. In some instances, there may be a requirement to request and/or provide or otherwise include or receive one or more one-time passwords/semi-permanent passwords/PINs/passphrases/security codes and/or the like with transaction requests made through the system using system components, without limitation. In some instances, there may not be a requirement to request and/or provide or otherwise include or receive one or more one-time passwords/semi-permanent passwords/PINs/passphrases/security codes and/or the like with transaction requests made through the system using system components, without limitation.

In some embodiments, users may electronically send, receive, order, donate, deliver, like, recommend, wish, and/or void, etc., redemption information 64 pertaining to one or more items, products, goods, services, money, payment, or credit via one or more emails to a system electronic address (e.g., a system email address such as “request@send1now.com”), without limitation. In some embodiments, users may physically send, receive, order, donate, deliver, like, recommend, wish, and/or void, etc., one or more items, products, goods, services, money, payment, or credit via one or more emails to a system electronic address, without limitation. In some embodiments, email may be used to perform other functions, like sign up and/or pay for events, create recipient lists, define vanity system electronic addresses, add/change/modify system user preferences 63, and/or the like, without limitation. In some embodiments, users may electronically send, receive, order, donate, deliver, like, recommend, wish, and/or void, etc., redemption information 64 pertaining to one or more items, products, goods, services, money, payment, or credit via one or more phone calls (e.g., automated, automated attendant, and/or navigable menu-based phone calls) to a system electronic address (e.g., system long code, such as “1-800-GOsend1”), without limitation. In some embodiments, users may physically send, receive, order, donate, deliver, like, recommend, wish, and/or void, etc., one or more items, products, goods, services, money, payment, or credit via one or more phone calls to a system electronic address, without limitation. In some embodiments, one or more phone calls may be made to the system to perform other functions, like sign up and/or pay for events, create recipient lists, define vanity system electronic addresses, add/change/modify system user preferences 63, and/or the like, without limitation. In some embodiments, similar functions may be performed via SMS/MMS/mobile messaging, for example, to the same long code used for phone call-based transactions, and/or to another system electronic address, such as a system short code. In some embodiments, users may electronically send, receive, order, donate, deliver, like, recommend, wish, and/or void, etc., redemption information 64 pertaining to one or more items, products, goods, services, money, payment, or credit via one or more SMS/MMS/mobile messages to a system electronic address (e.g., system long code, such as “1-800-GOsend1” or system short code, such as “73631” or “send1”), without limitation. In some embodiments, users may physically send, receive, order, donate, deliver, like, recommend, wish, and/or void, etc., one or more items, products, goods, services, money, payment, or credit via one or more SMS/MMS/mobile messages to a system electronic address, without limitation. In some embodiments, one or more SMS/MMS/mobile messages may be made to the system to perform other functions, like sign up and/or pay for events, create recipient lists, define vanity system electronic addresses, add/change/modify system user preferences 63, and/or the like, without limitation. In some embodiments, users may electronically send, receive, order, donate, deliver, like, recommend, wish, and/or void, etc., redemption information 64 pertaining to one or more items, products, goods, services, money, payment, or credit via one or more web submissions to a system-integrated web page of a website (e.g., a system website) or mobile application 147, without limitation. In some embodiments, users may physically send, receive, order, donate, deliver, like, recommend, wish, and/or void, etc., one or more items, products, goods, services, money, payment, or credit via one or more web submissions, without limitation. In some embodiments, one or more web submissions may be made to the system to perform other functions, like sign up and/or pay for events, create recipient lists, define vanity system electronic addresses, add/change/modify system user preferences 63, and/or the like, without limitation. In some embodiments, users may electronically send, receive, order, donate, deliver, like, recommend, wish, and/or void, etc., redemption information 64 pertaining to one or more items, products, goods, services, money, payment, or credit via one or more social media posts to and/or containing a system social electronic address (e.g., “@send1now” or “@send1”) and/or via one or more social media posts to a social media website page (e.g., “https://www.twitter.com/send1now . . . ” or “https://www.facebook.com/send1now . . . ”), without limitation. In some embodiments, users may physically send, receive, order, donate, deliver, like, recommend, wish, and/or void, etc., one or more items, products, goods, services, money, payment, or credit via one or more social media posts, without limitation. In some embodiments, one or more social media posts may be made to the system to perform other functions, like sign up and/or pay for events, create recipient lists, define vanity system electronic addresses, add/change/modify system user preferences 63, and/or the like, without limitation.

As stated herein, according to some embodiments, any one of, any combination of, and/or all of the platforms described herein may be conveniently used to perform transactions through the system and its components, using system components. In some embodiments, each platform may utilize software 147 (e.g., scripts, API's, apps, parsing algorithms, logical expressions, message piping techniques, scanning techniques, and/or the like, etc.), without limitation. According to some embodiments, communications made to the system via different platforms may be configured to communicate with the same database(s) and/or same user information 8 (e.g., profile information 130) stored within the same database(s), without limitation. It is anticipated that third party platforms may take advantage of the inventive technology in whole, or in part, without limitation.

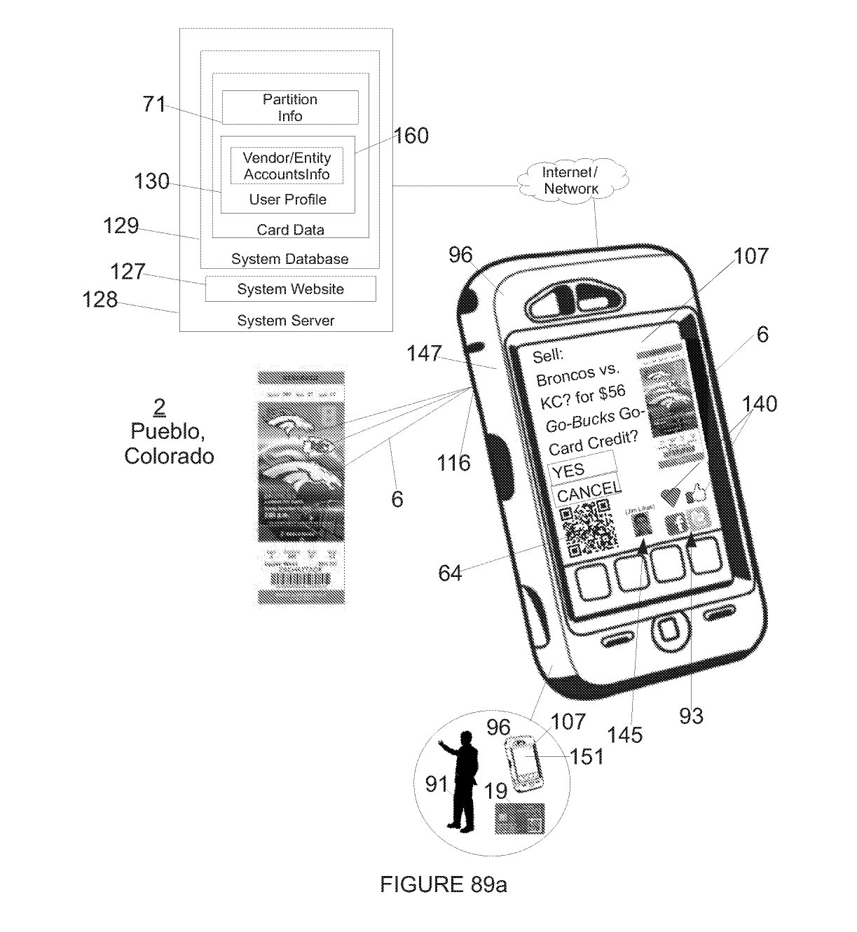

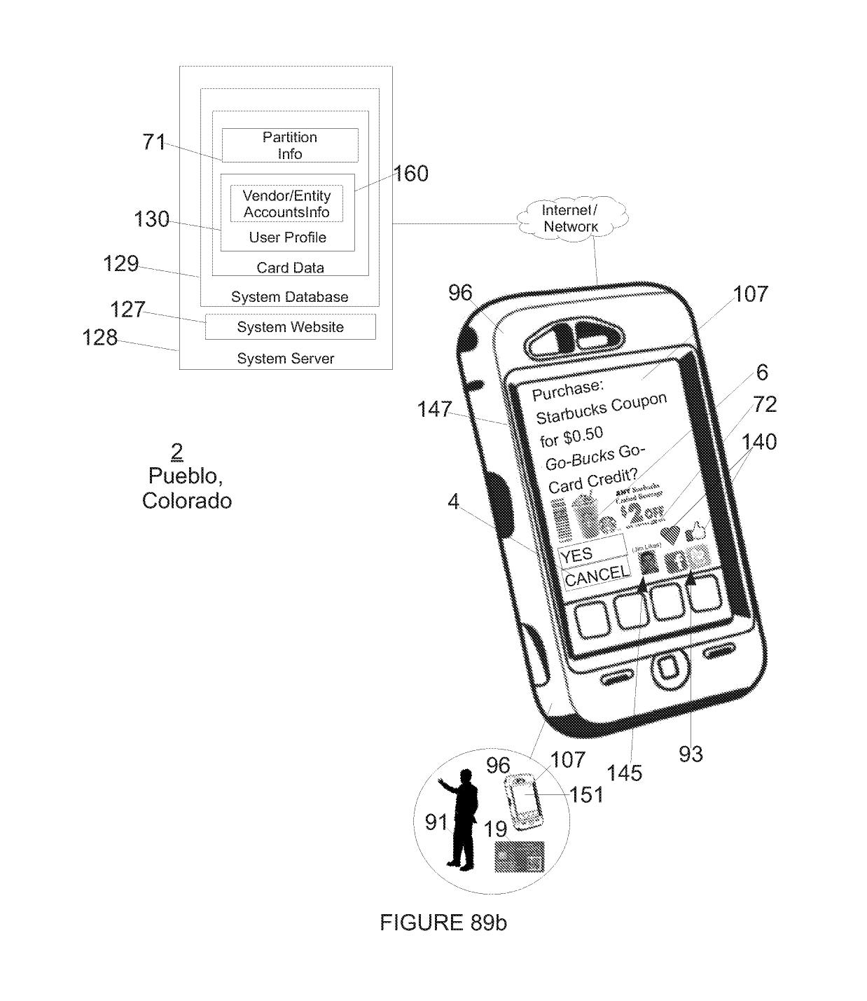

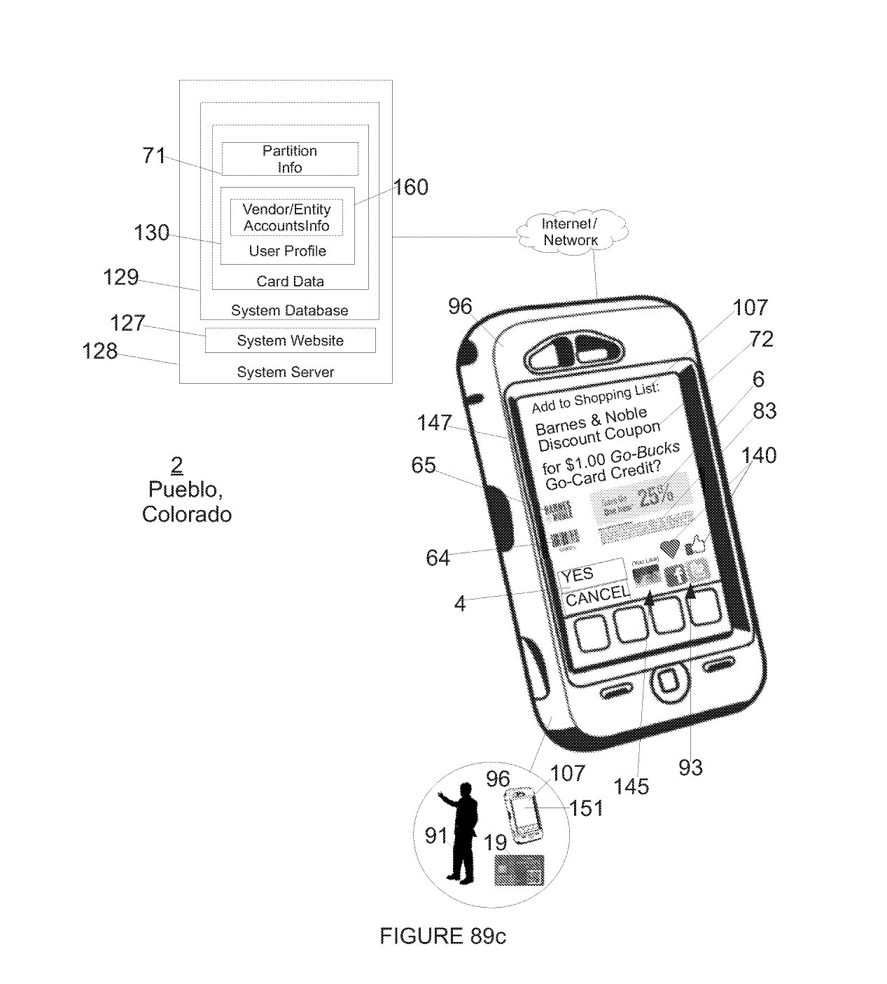

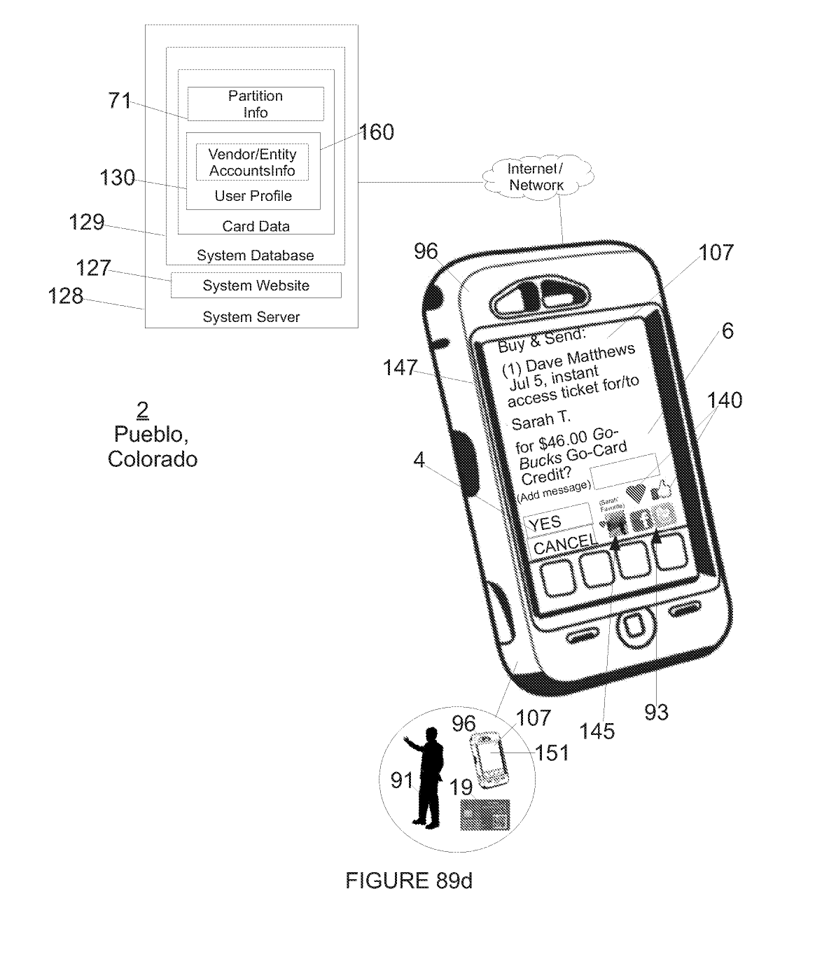

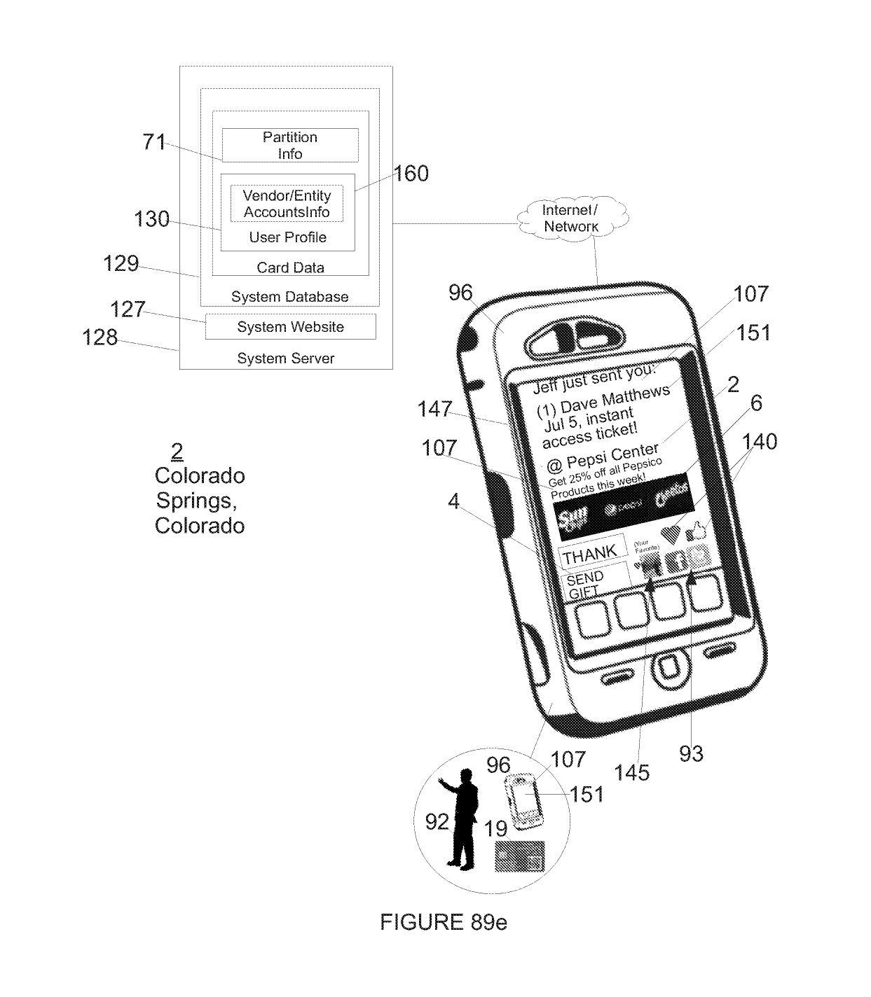

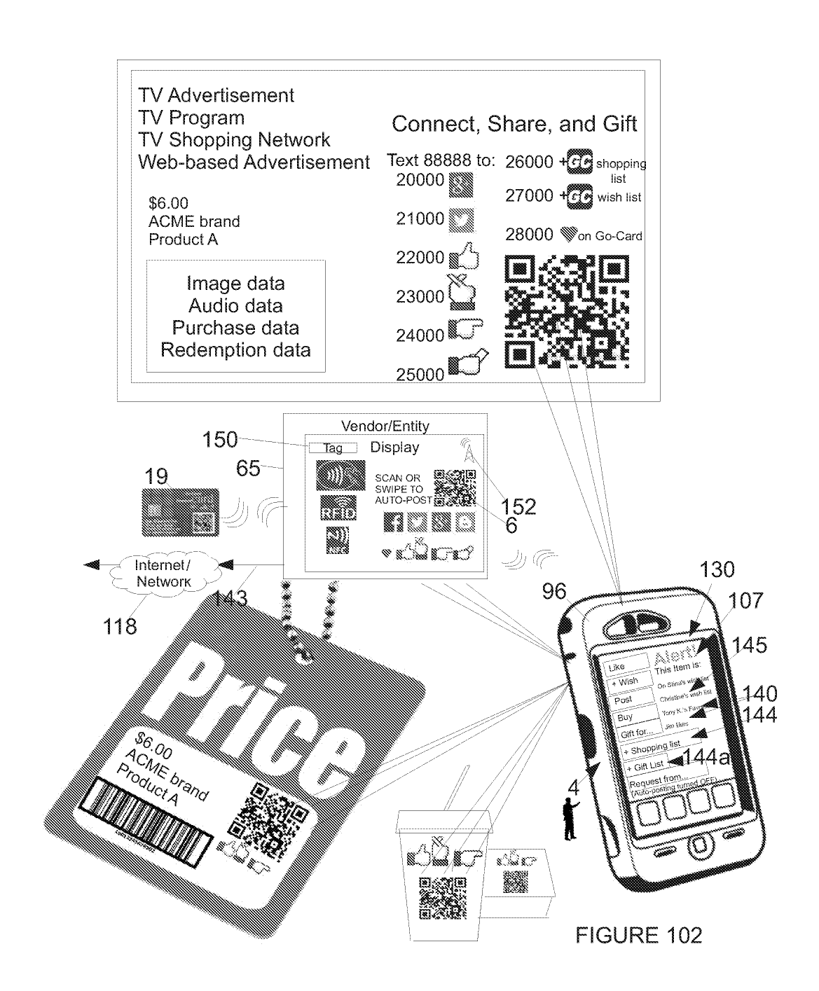

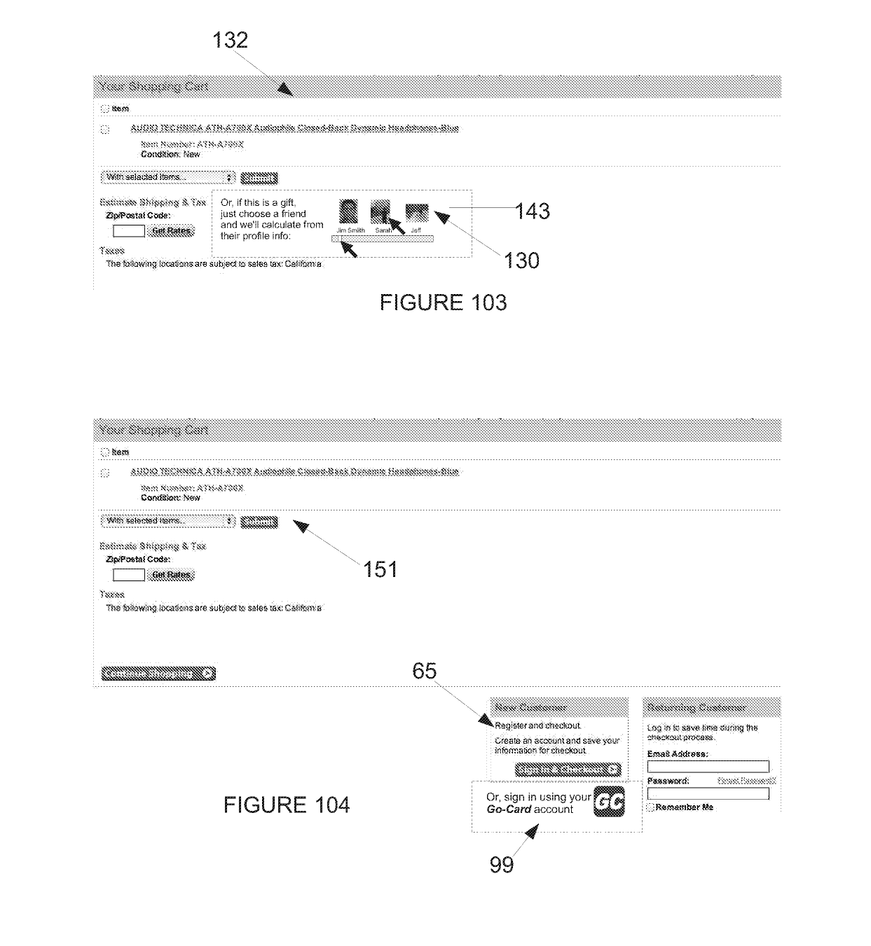

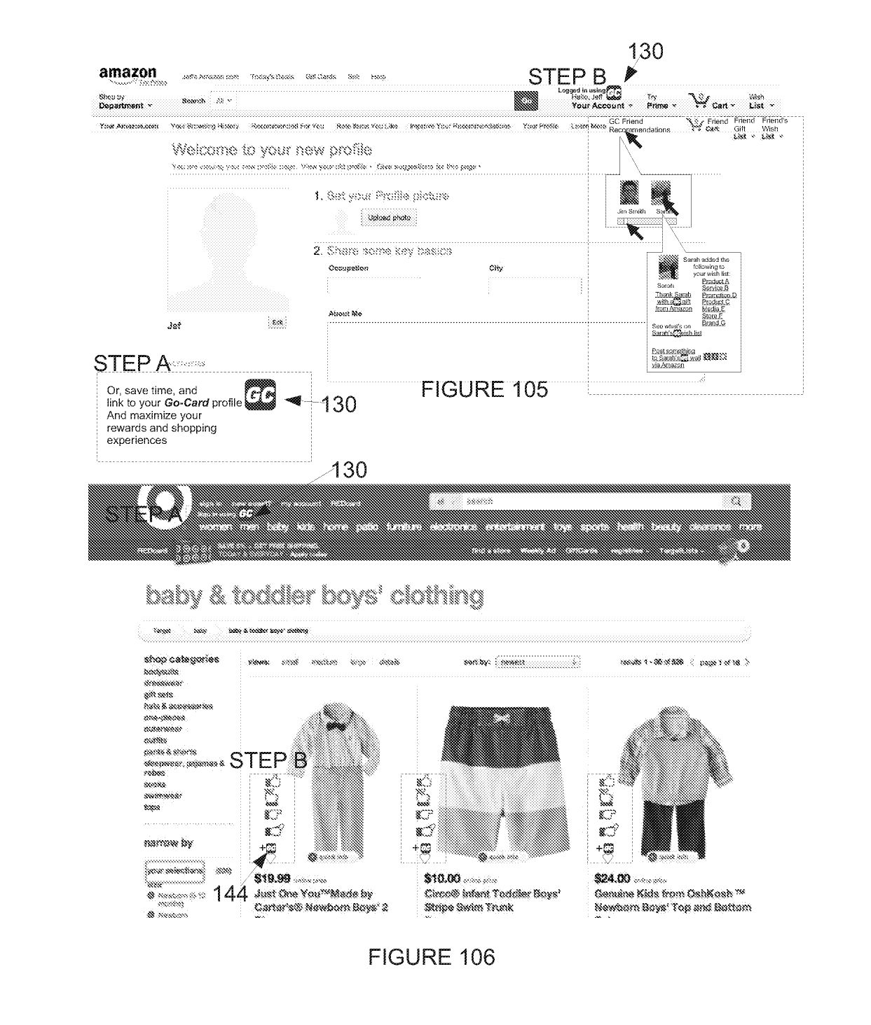

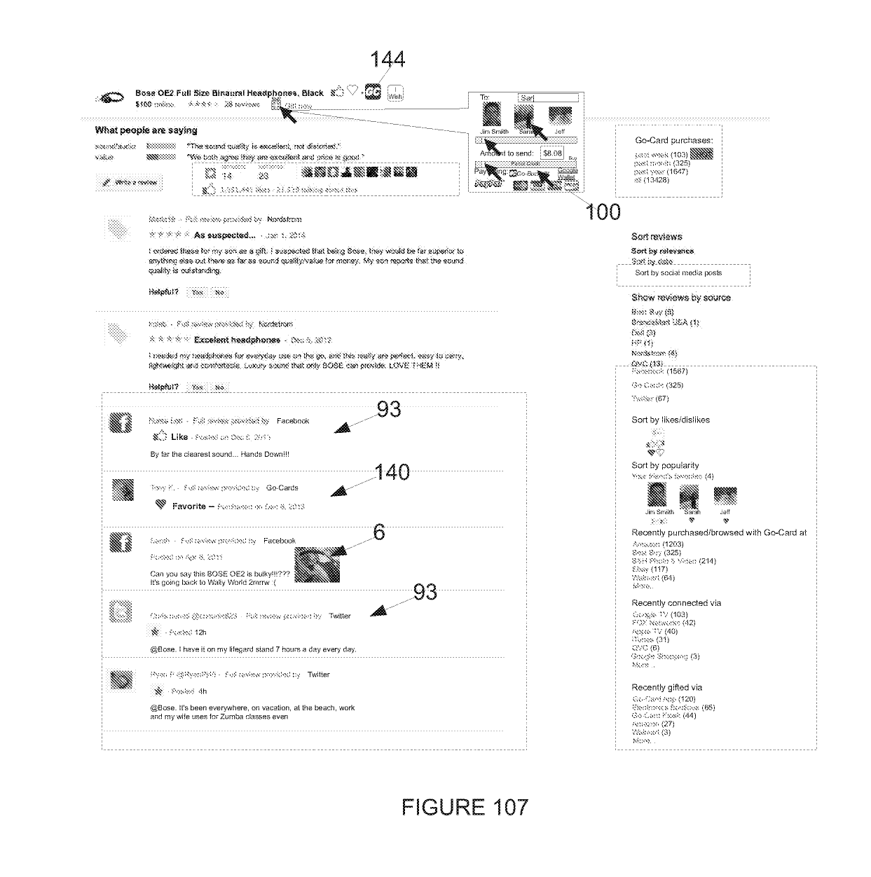

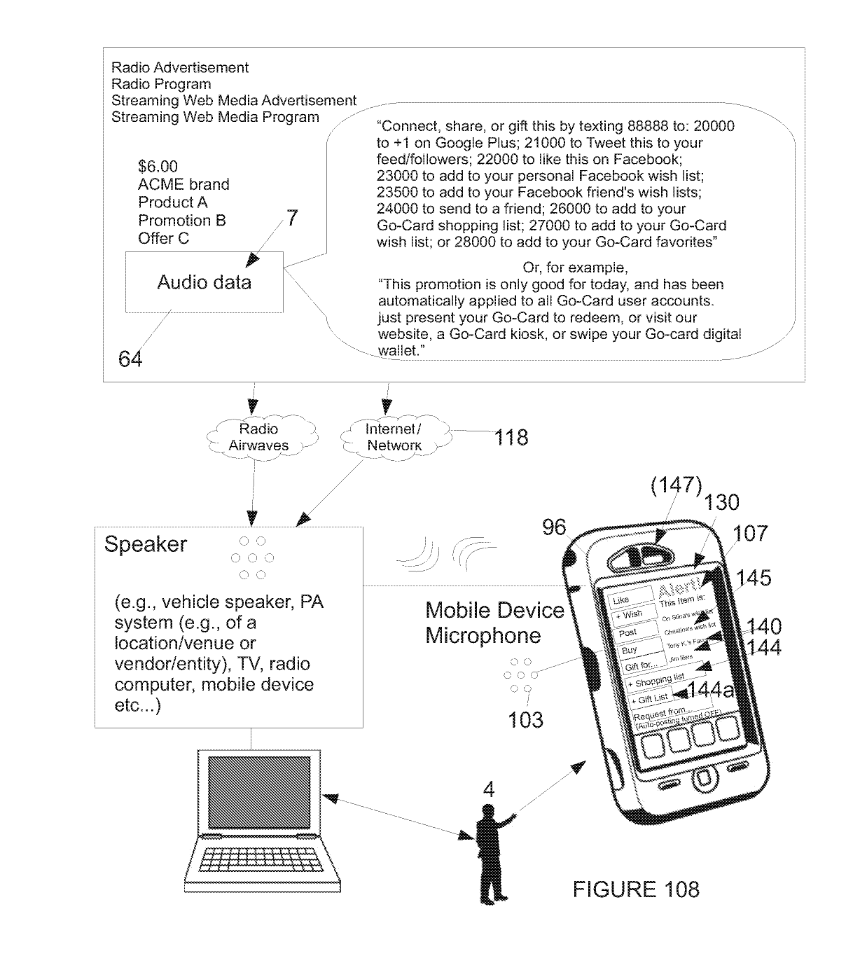

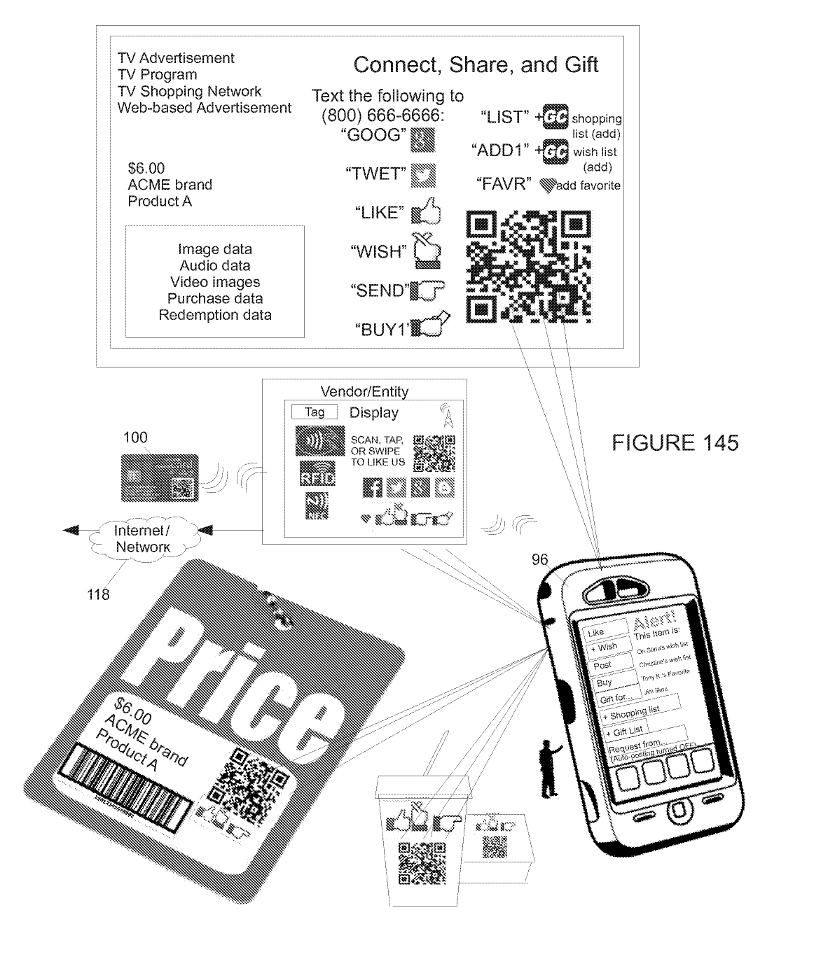

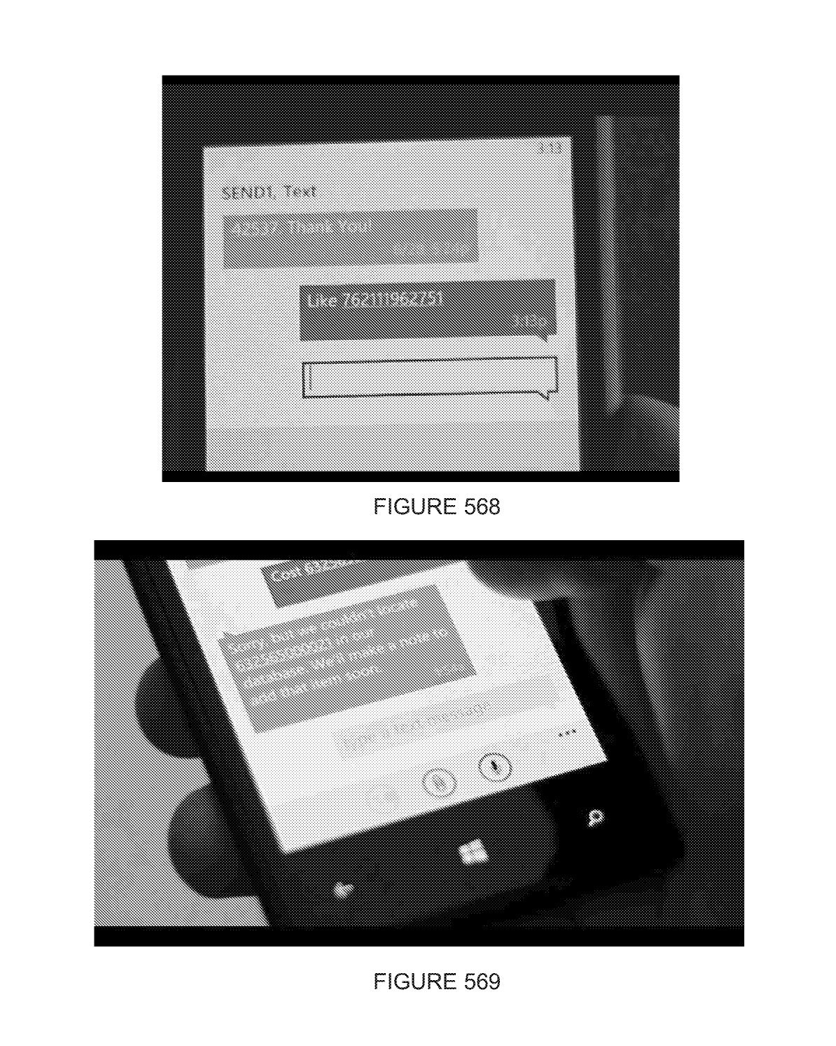

According to some embodiments, a system platform may allow users to create, keep, update, modify, or delete one or more portable and/or universal registries (e.g., one or more shopping lists 144, wish lists 144a, gift lists, and/or the like) which may be visible to friends and family and/or to the public, without limitation. This may be appreciated from at least FIGS. 89c, 102, 145, 568.

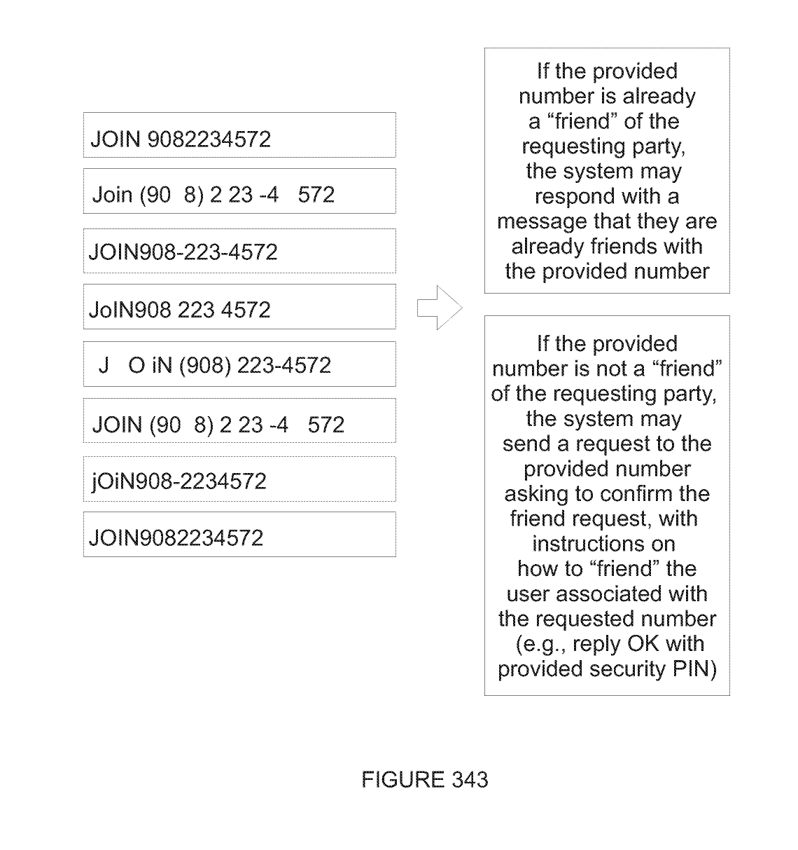

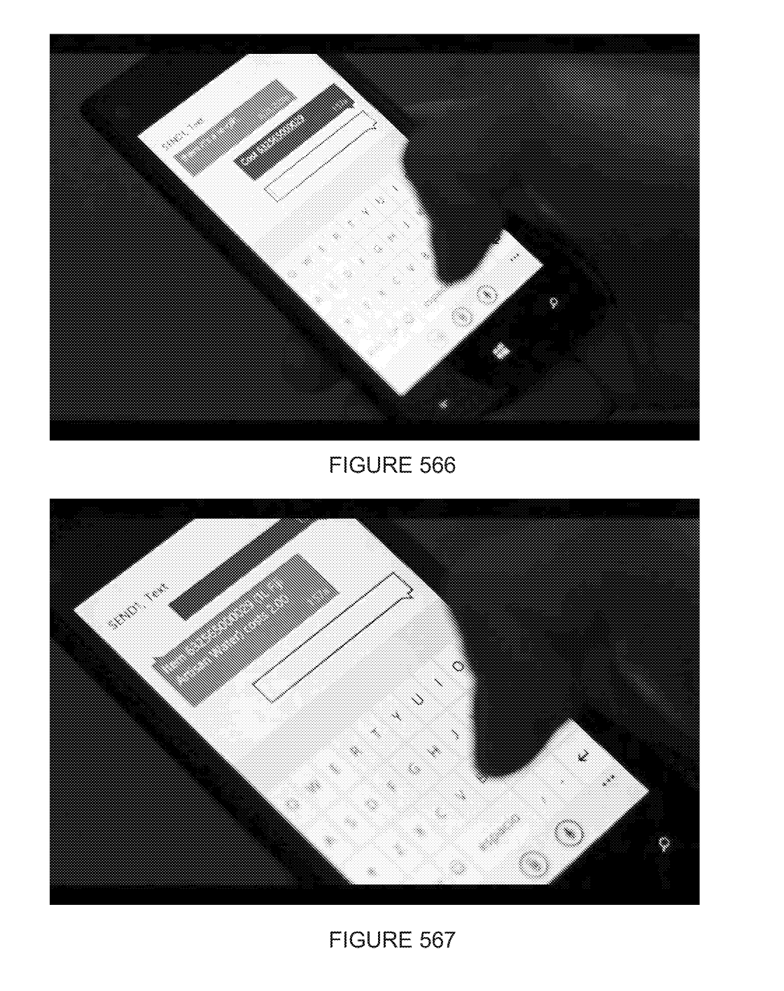

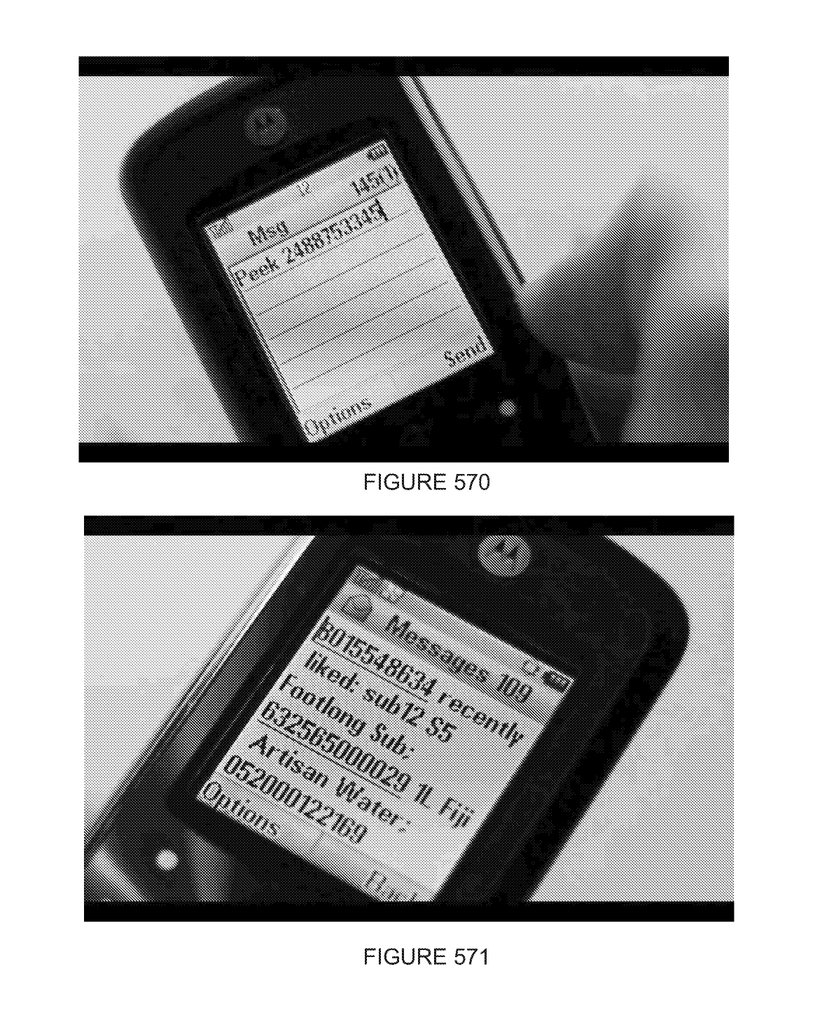

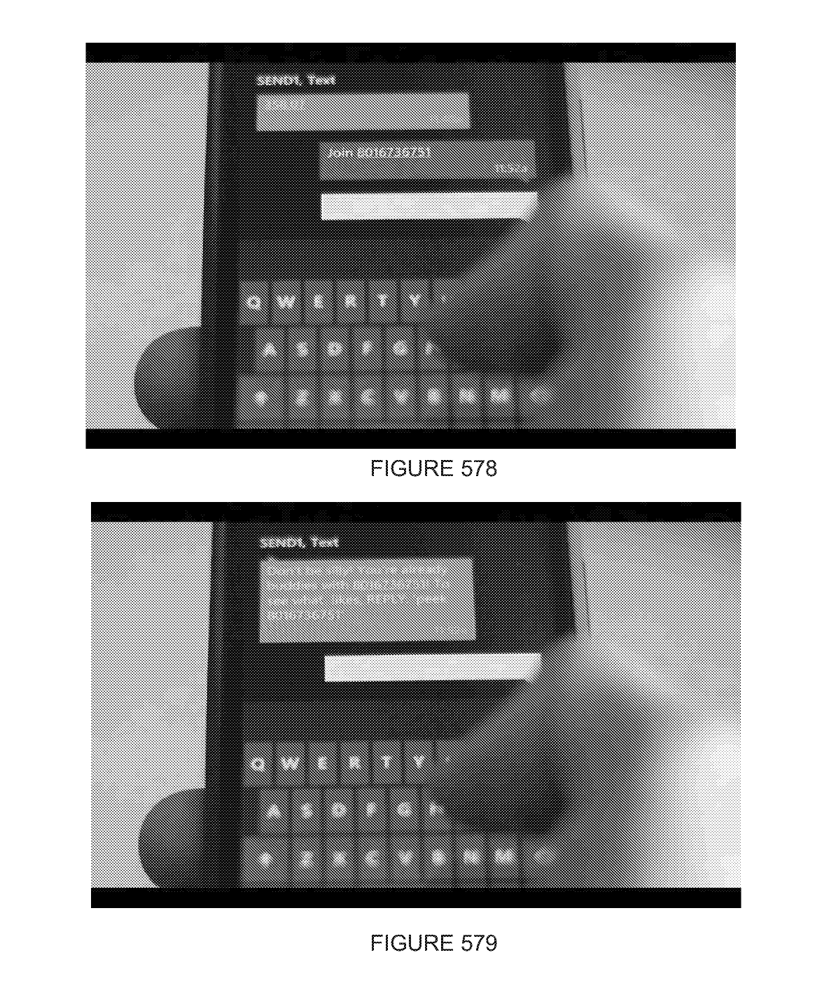

In some embodiments, a user may determine the cost of an item, product, good, or service, using system components, via one of the platforms described herein. For example, as suggested in FIGS. 566 and 567, a user may, via an SMS-based platform and respective user interface 106, text the command “cost” (or the like, such as “price”, “info”, etc.) with one or more respective item codes, vanity item codes, hashtags, numerical barcode numbers (e.g., a GTIN number), and/or the like, without limitation. According to some embodiments, the system may utilize or otherwise incorporate third party software, third party information, and/or third party websites (e.g., websites of participating entities 65) to deliver cheap prices, the cheapest prices, discounted prices, suggested retail prices, manufacturer prices, and/or sale prices to system users, as well as various physical and/or electronic delivery options, without limitation. As mentioned herein (and as may be appreciated from FIG. 294), users may define preferences 63 as a user input 4, wherein preference information may comprise few or a plethora of options pertaining to transactions, delivery of redemption information 64, and/or use of redemption information 64, without limitation. According to some embodiments, defining preferences 63 may comprise a step of selecting one or more preferred vendors to redeem received funds and/or credits via the system (e.g., where they wish to redeem (e.g., online, in-store-pickup, particular venue/location 2, delivery, etc.), when they wish to redeem, which participating entity(ies) they wish to utilize for transactions, which types of items/products/goods/services they want redeemed by certain vendors, how certain types of redemptions are preferred to be utilized (e.g., in-store pick up vs. delivery vs. electronic delivery), etc., without limitation. In some embodiments, user registries may be public and/or may be made available for inspection by any other system user or person/entity in general, for example, by providing a “peek” command, a “peek” mobile application button, and/or the like, without limitation (see, for example, non-limiting exemplary embodiments shown in FIGS. 570-574). In other, preferred embodiments, users may only be permitted to inspect registries of persons who may be “friends” or “buddies” (e.g., FIG. 457). According to some embodiments, this may be achieved by using system recognized commands, such as the “join” and/or “ok” commands as suggested in FIG. 343 and FIGS. 575-579, without limitation.

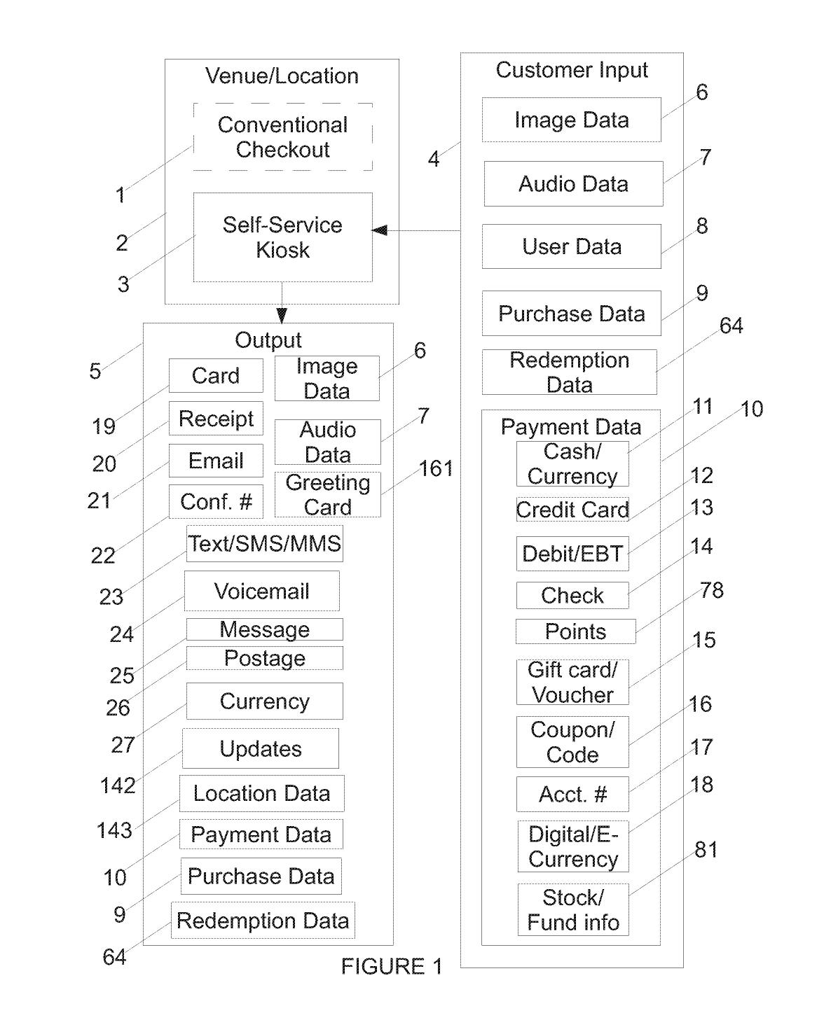

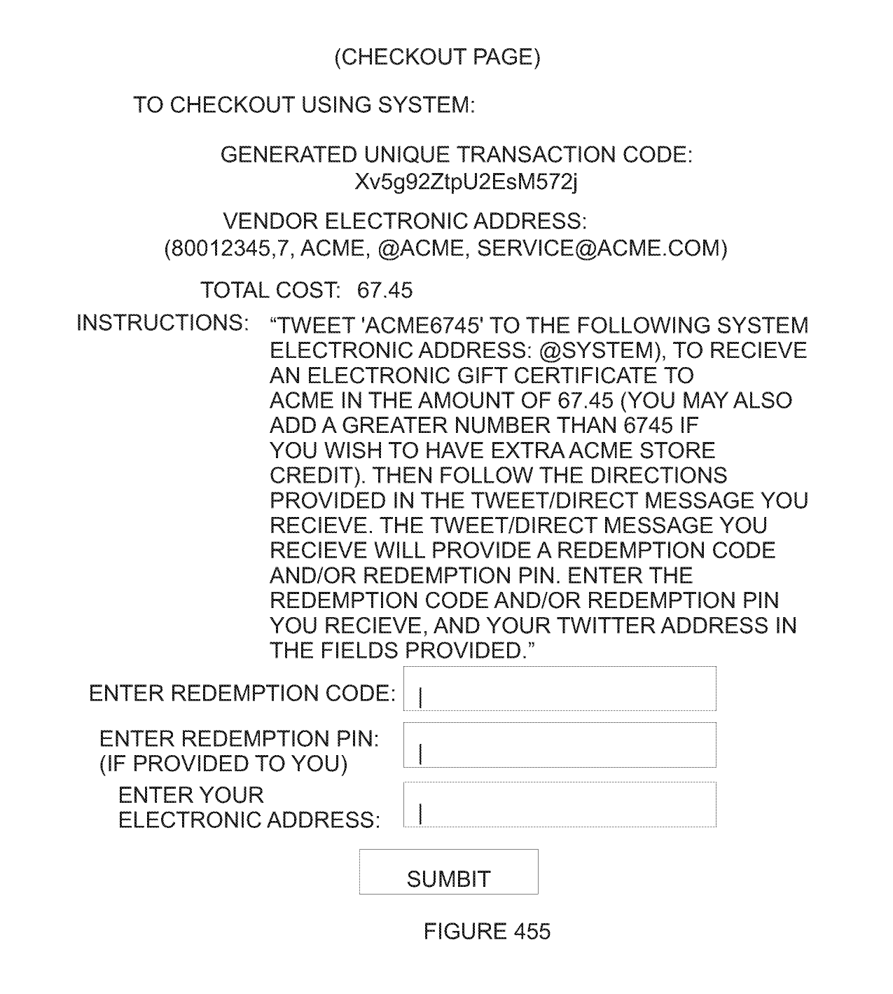

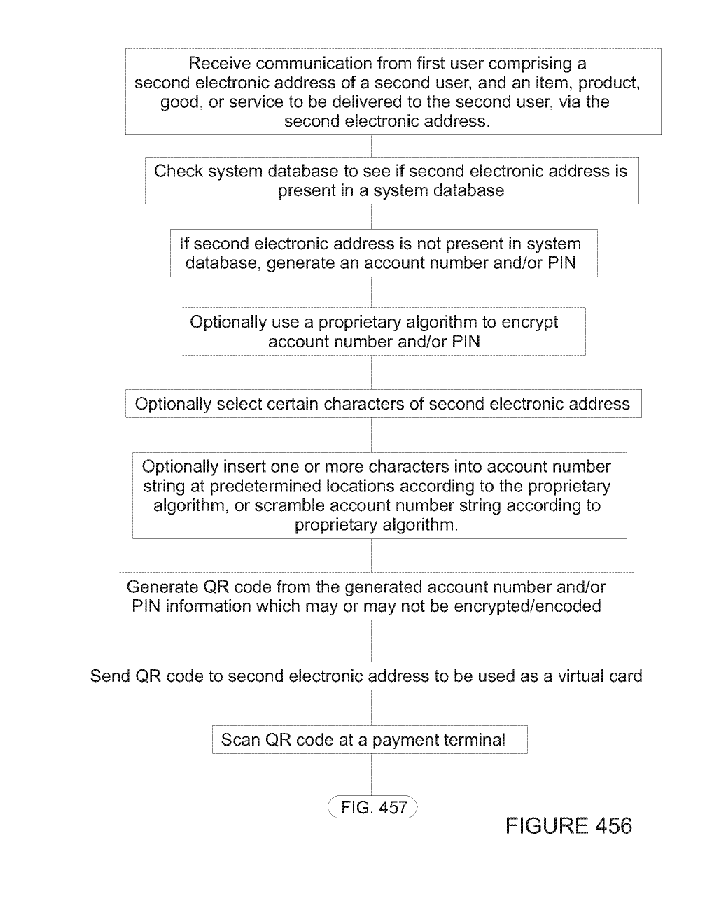

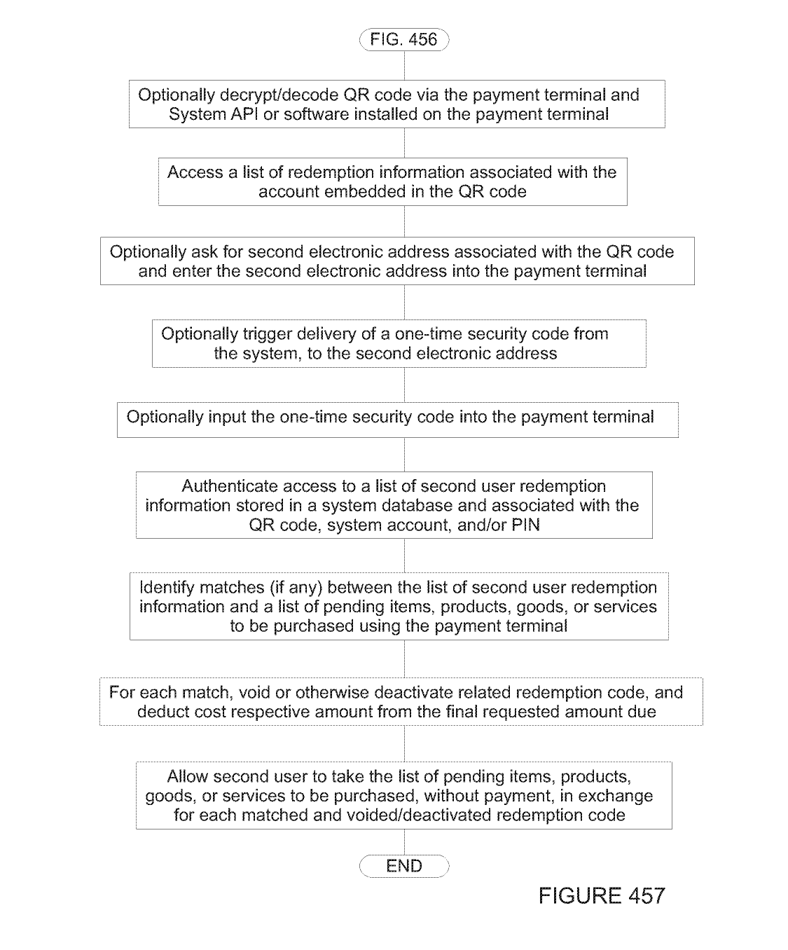

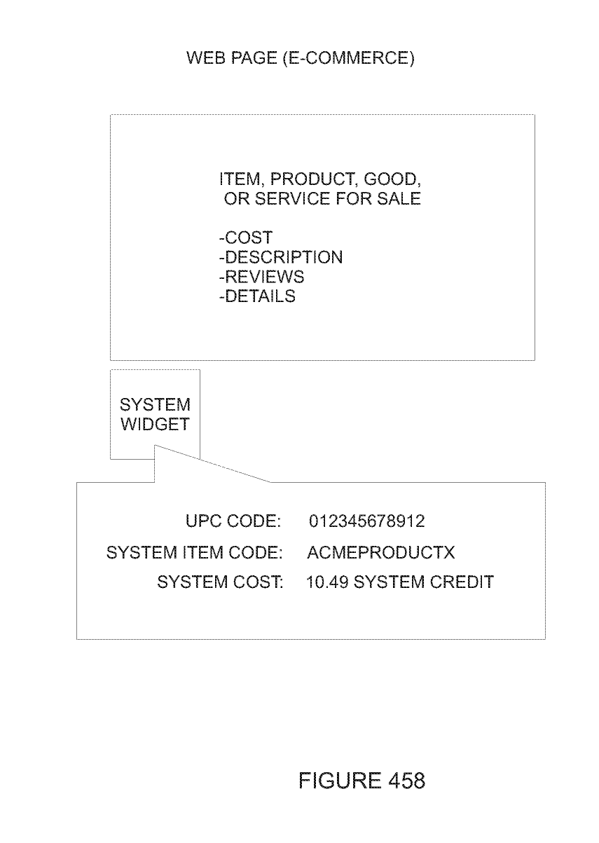

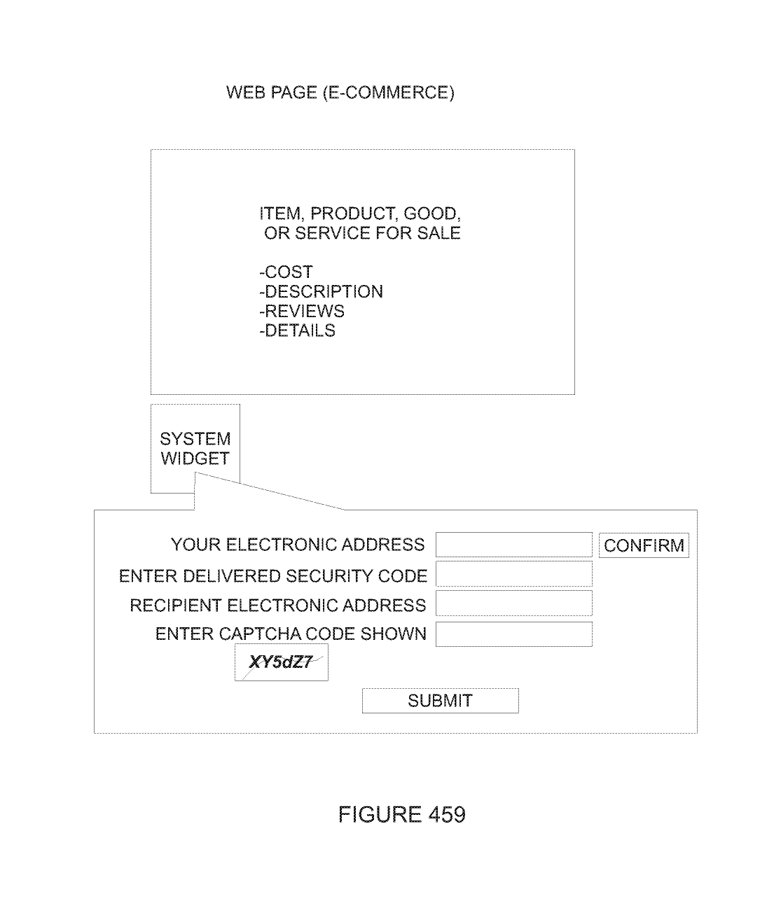

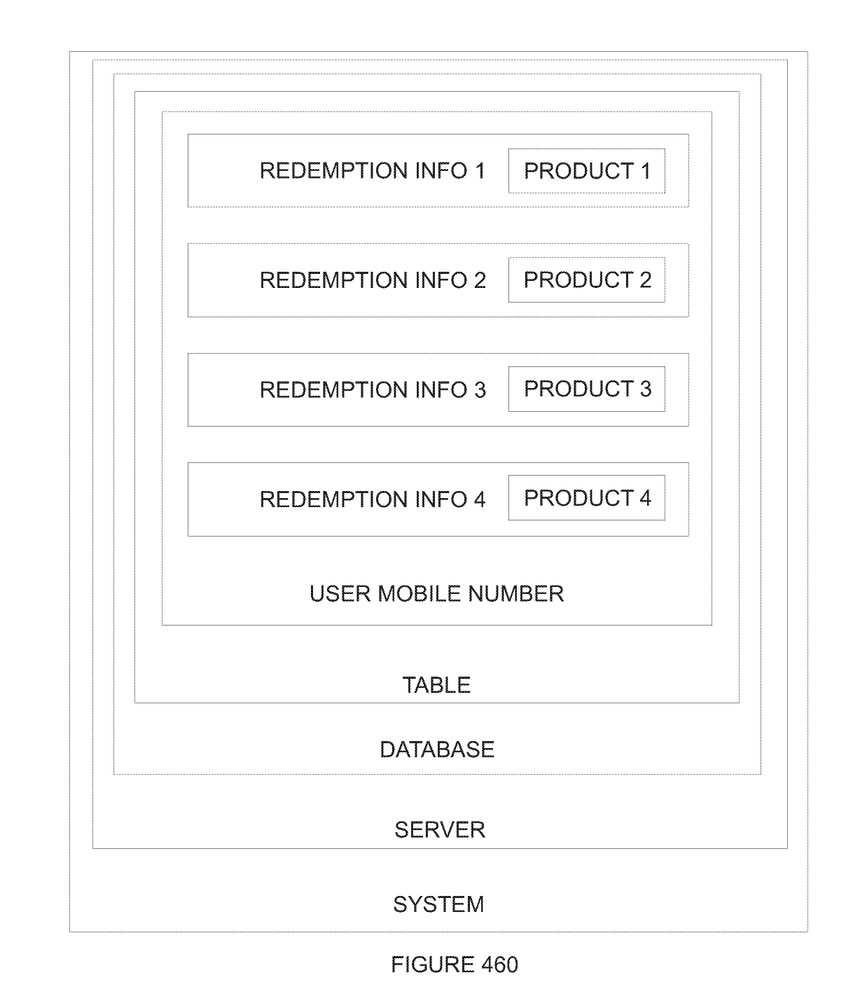

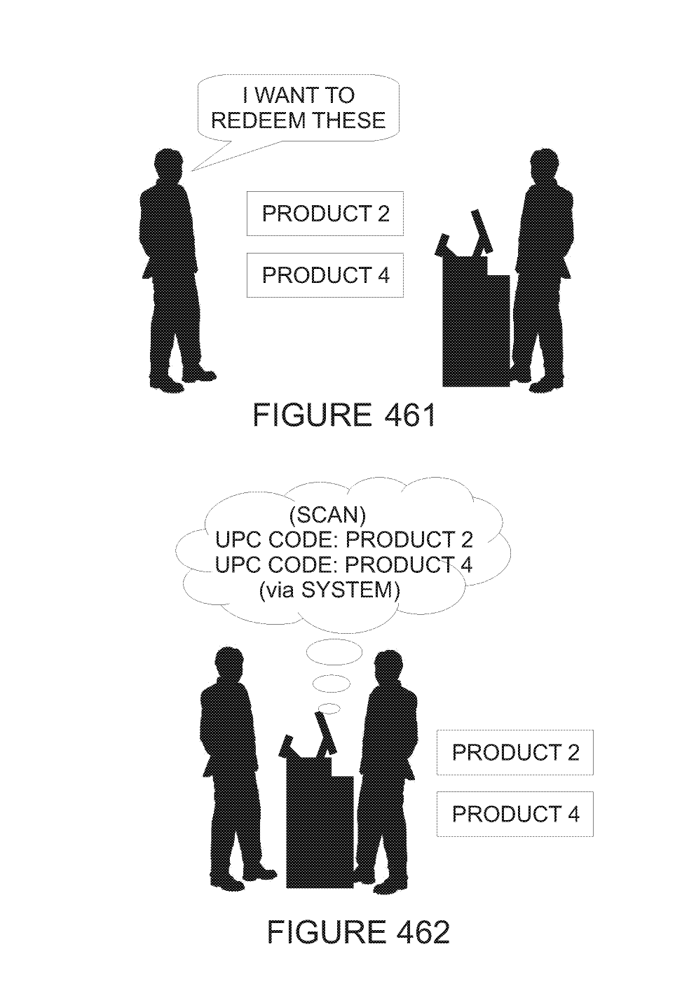

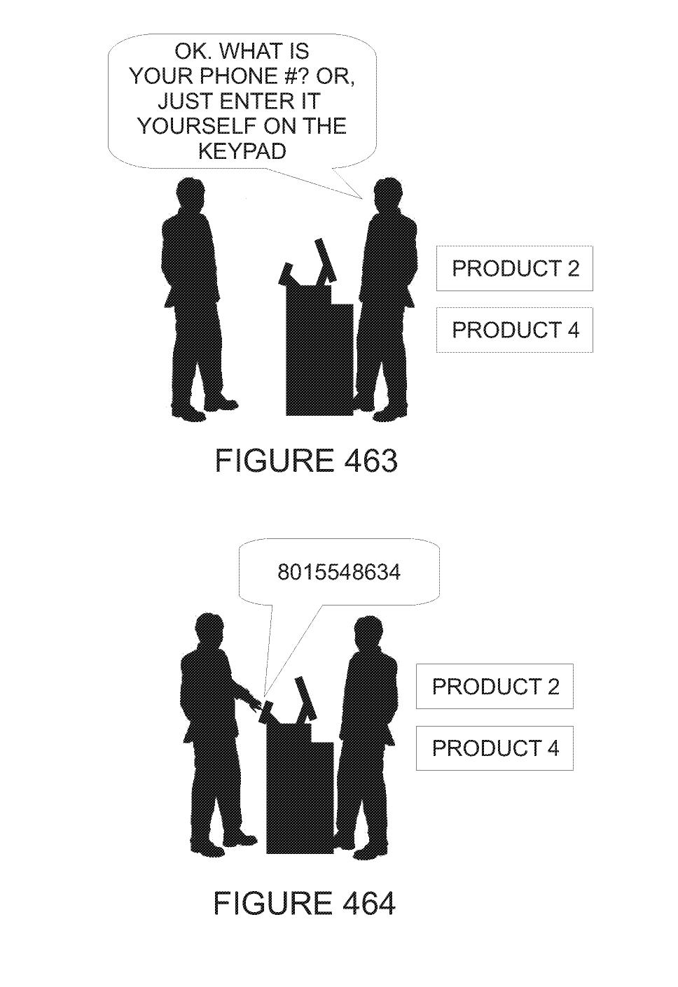

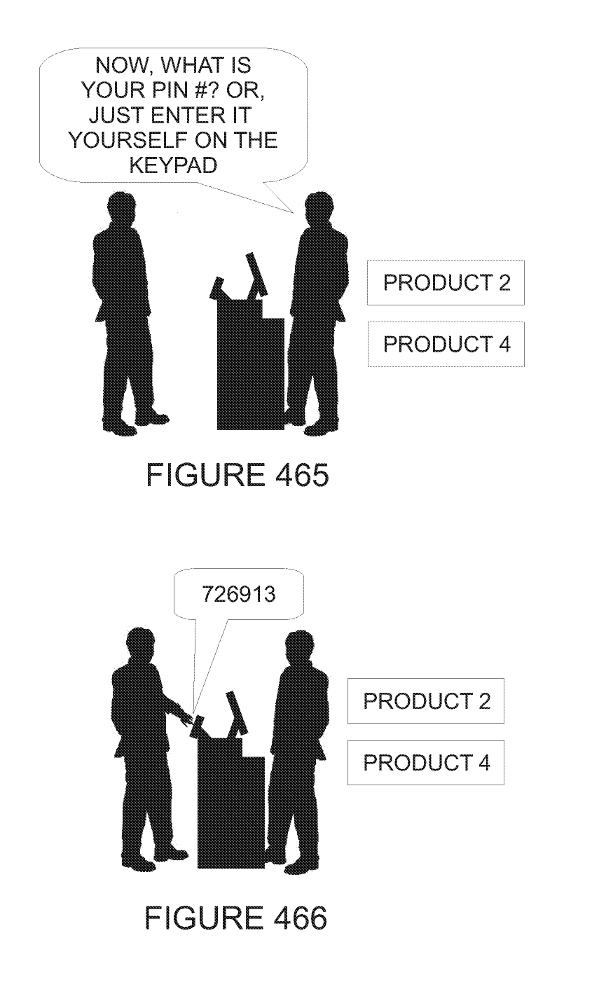

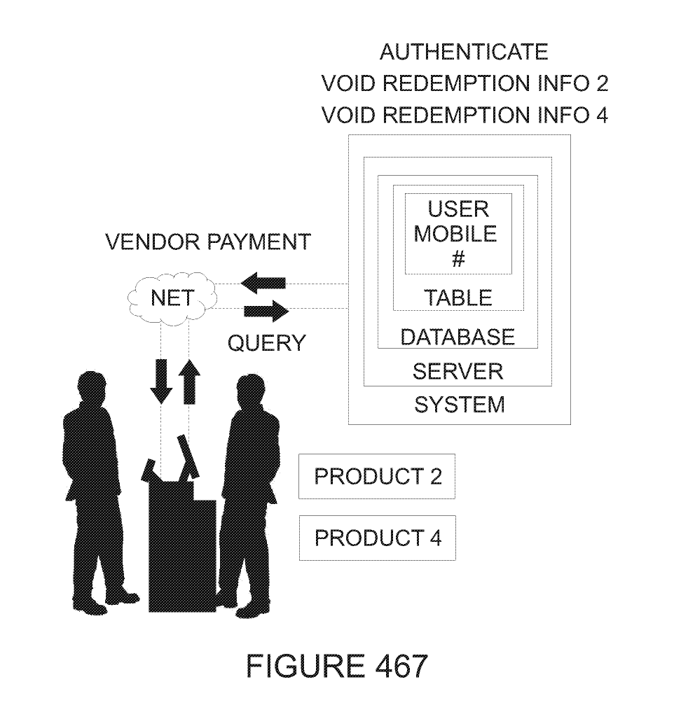

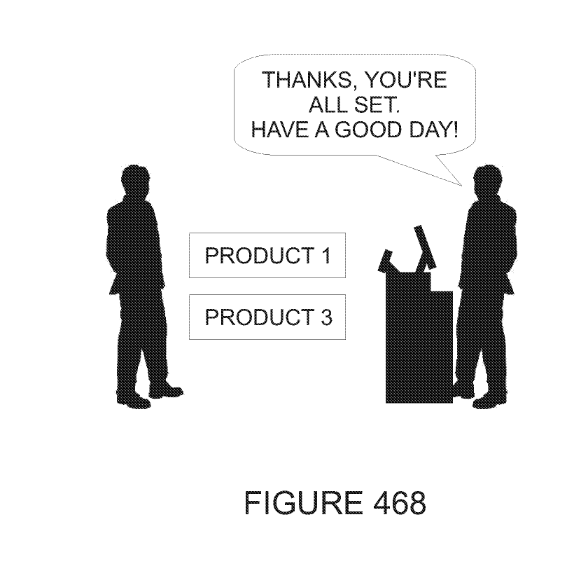

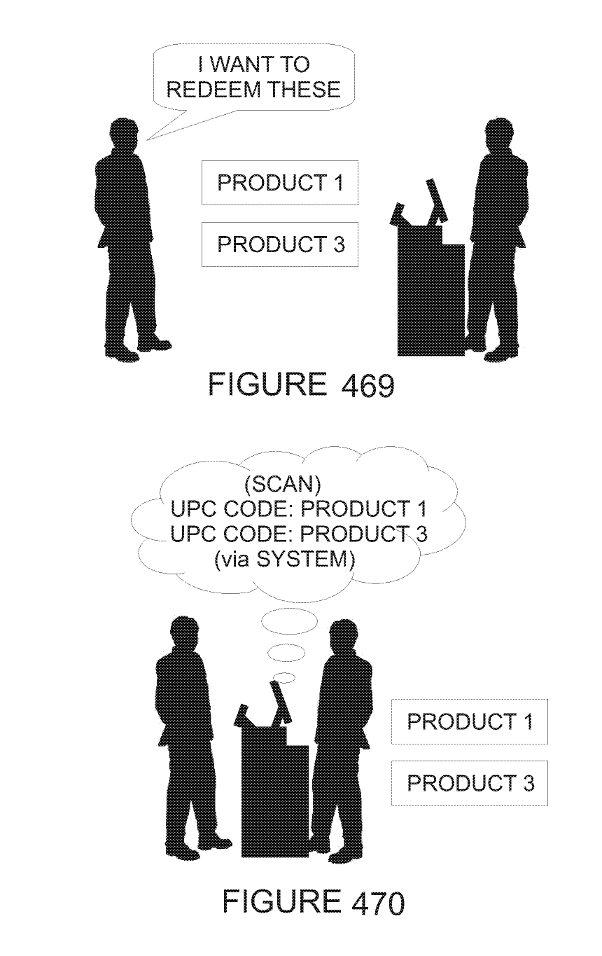

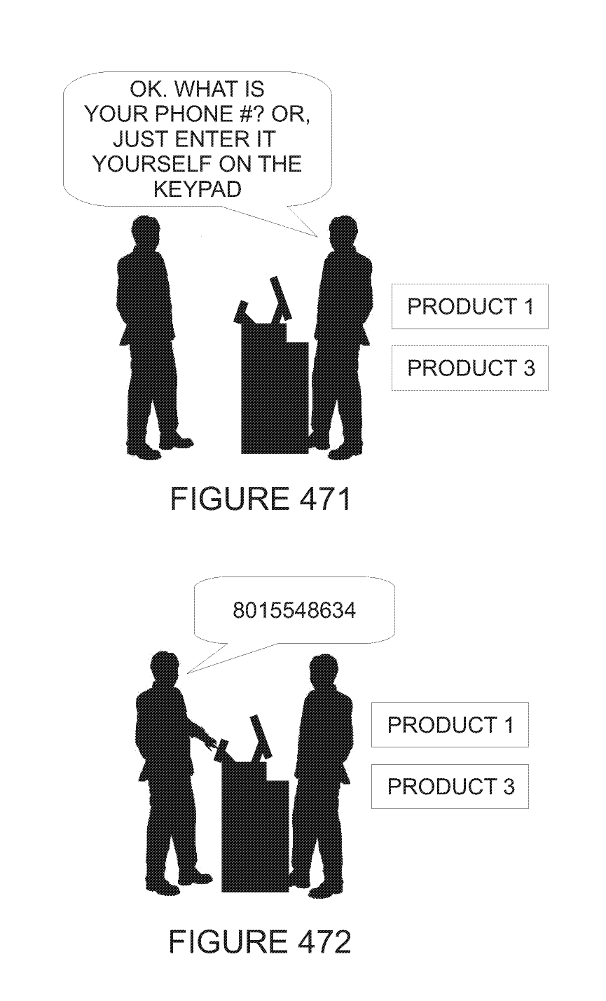

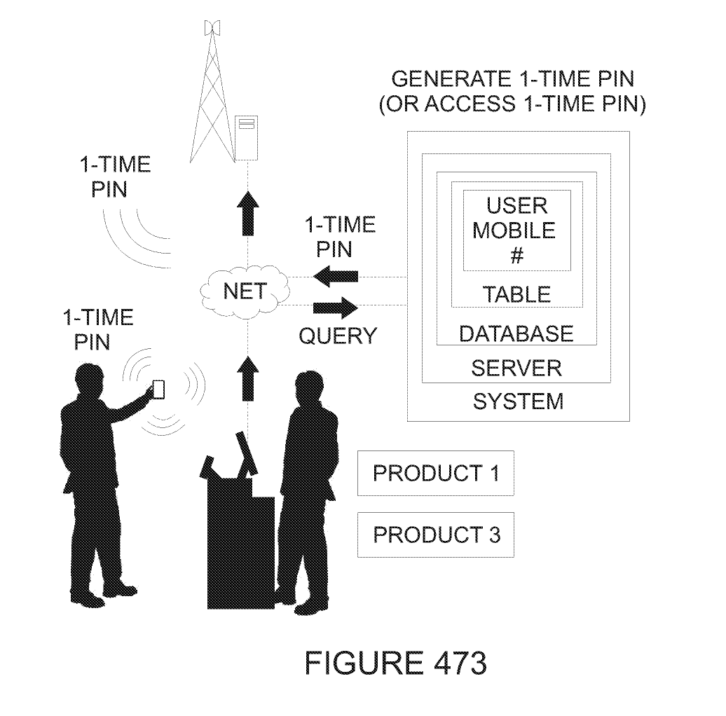

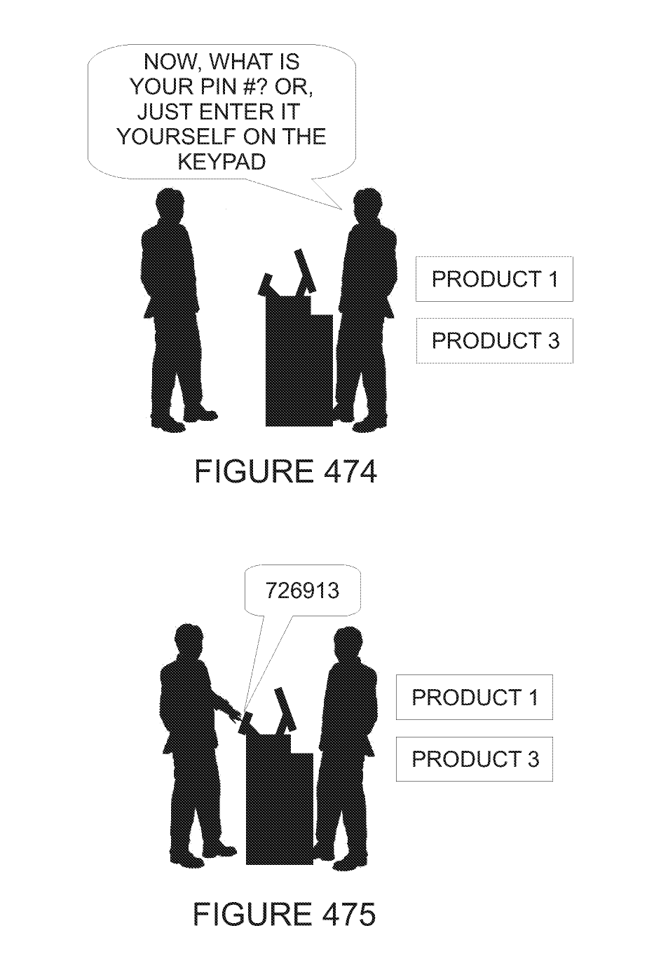

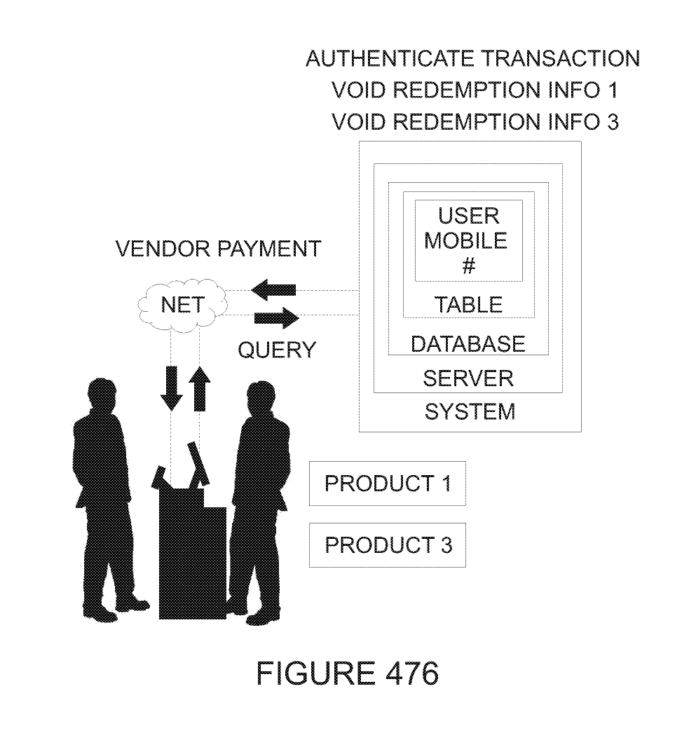

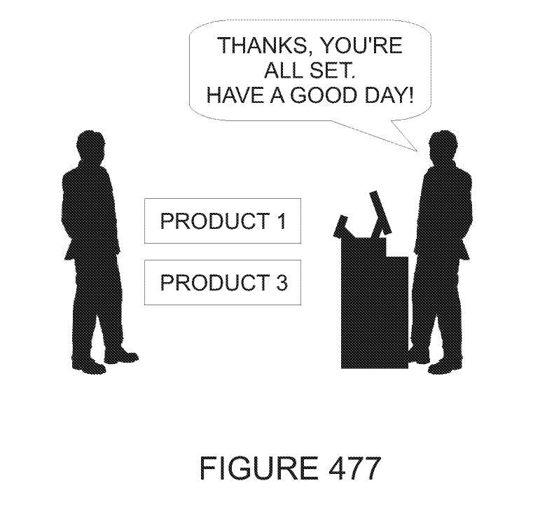

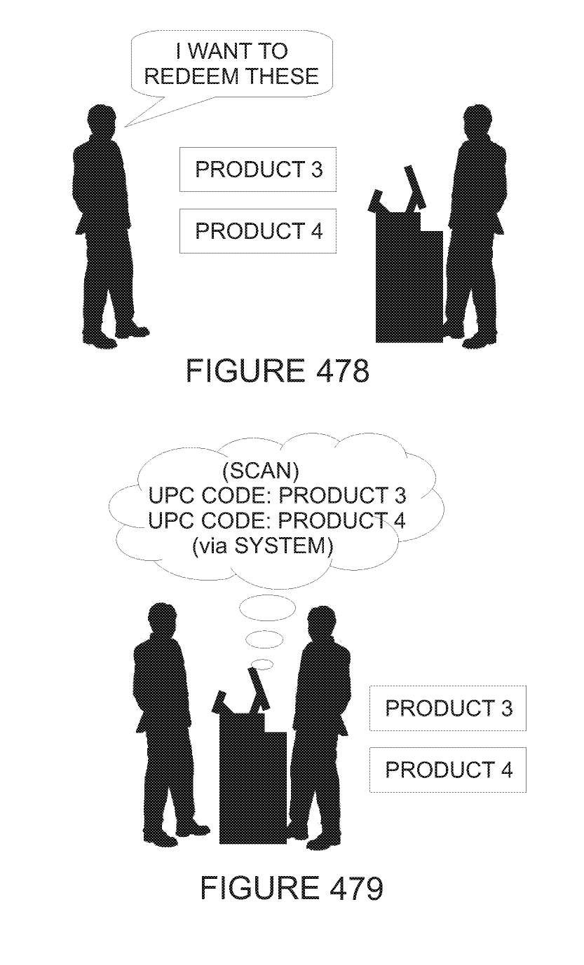

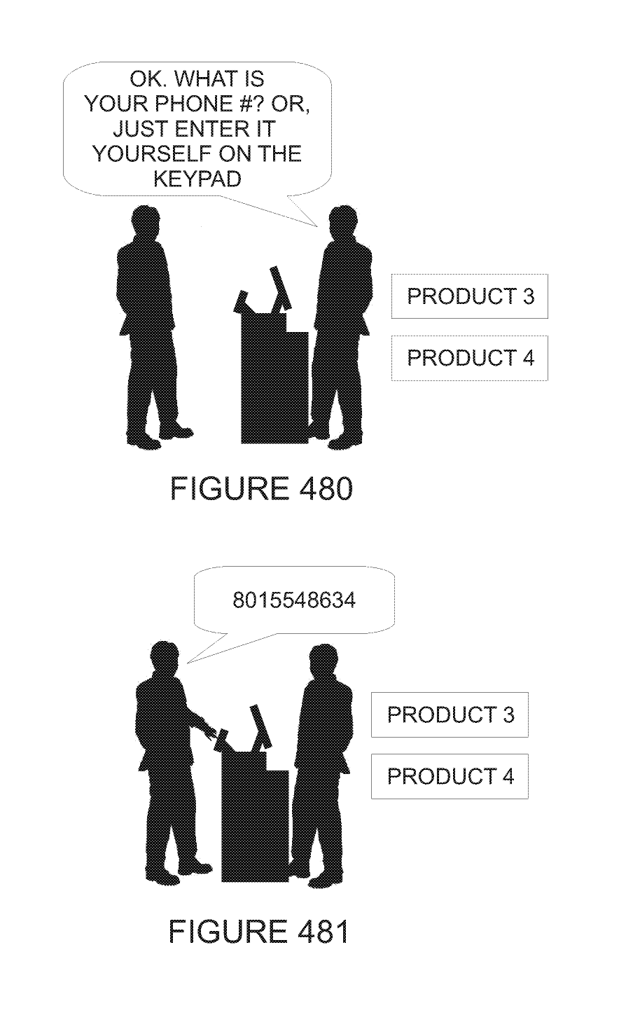

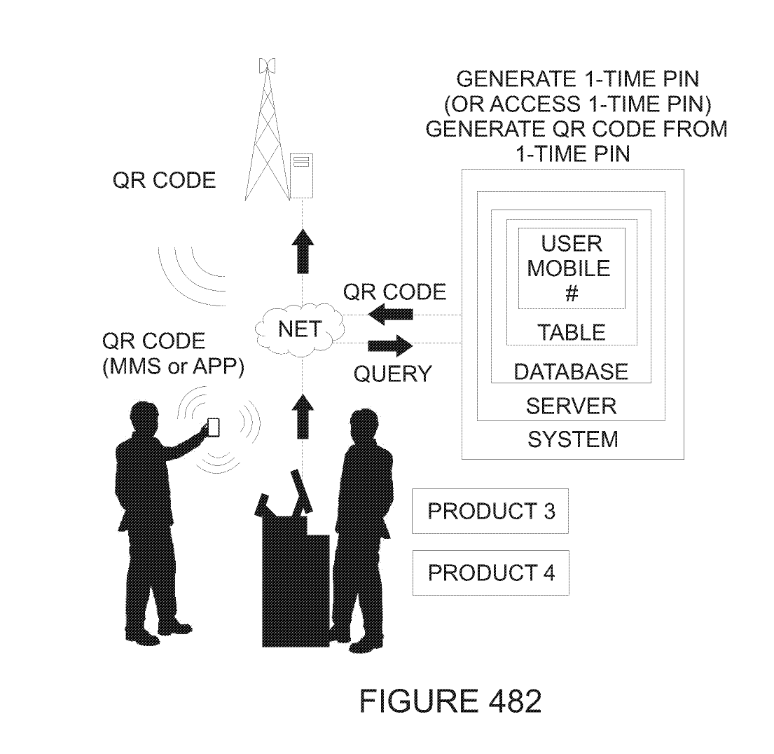

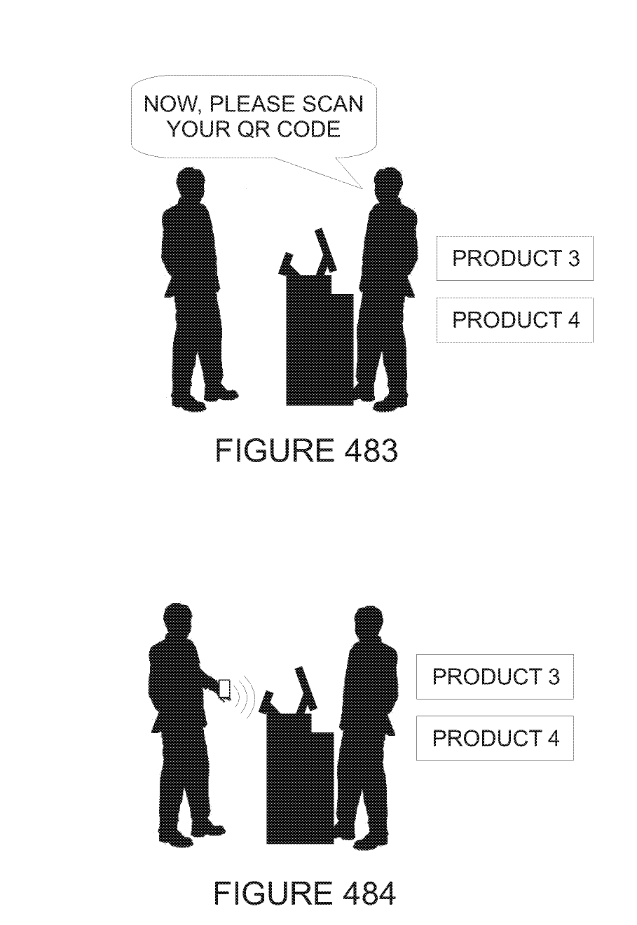

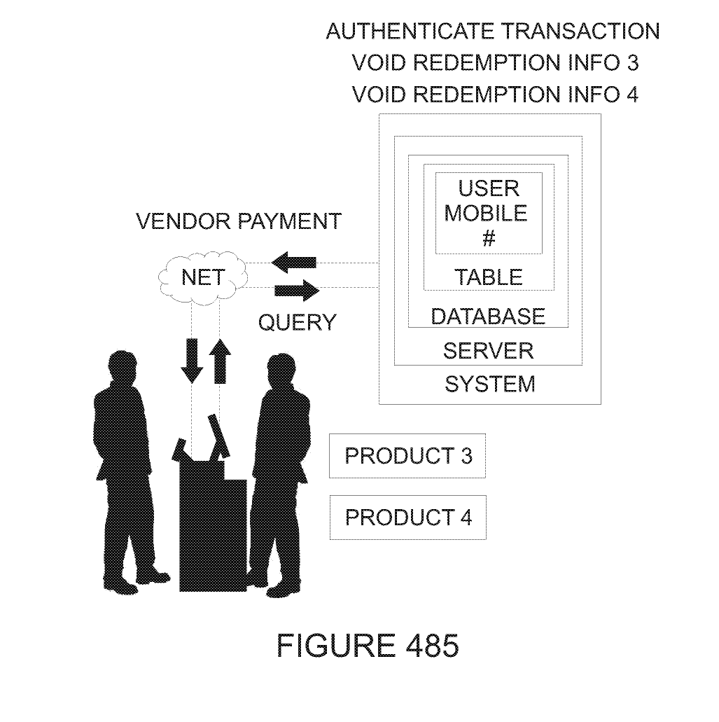

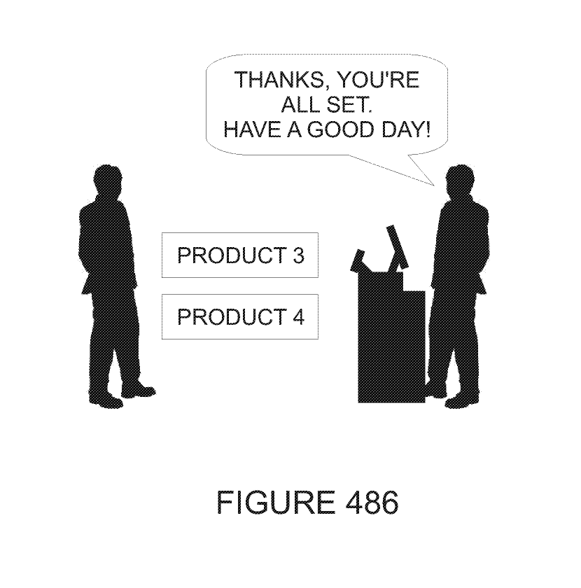

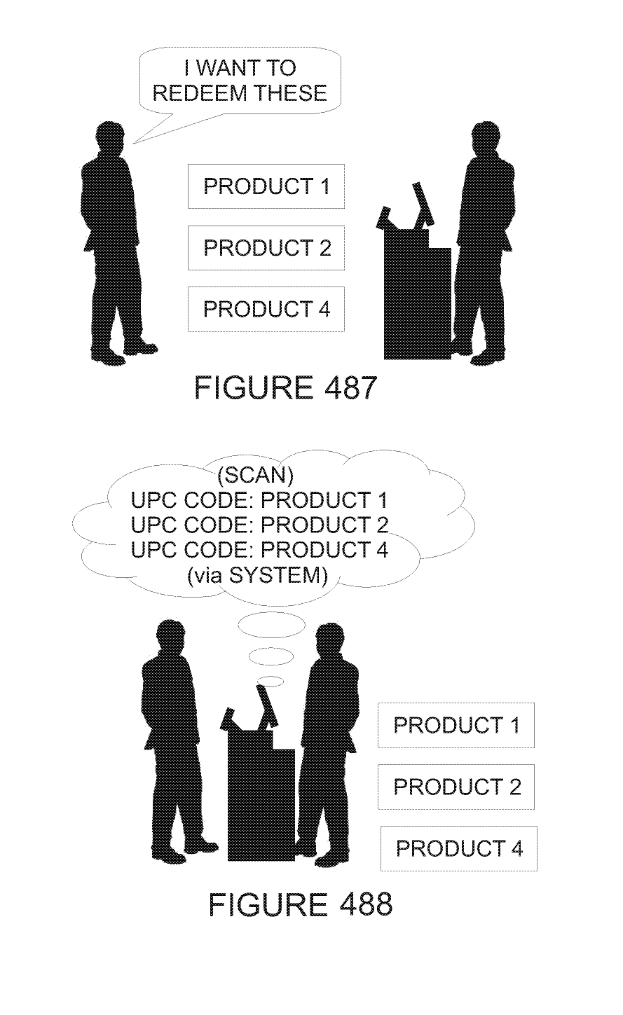

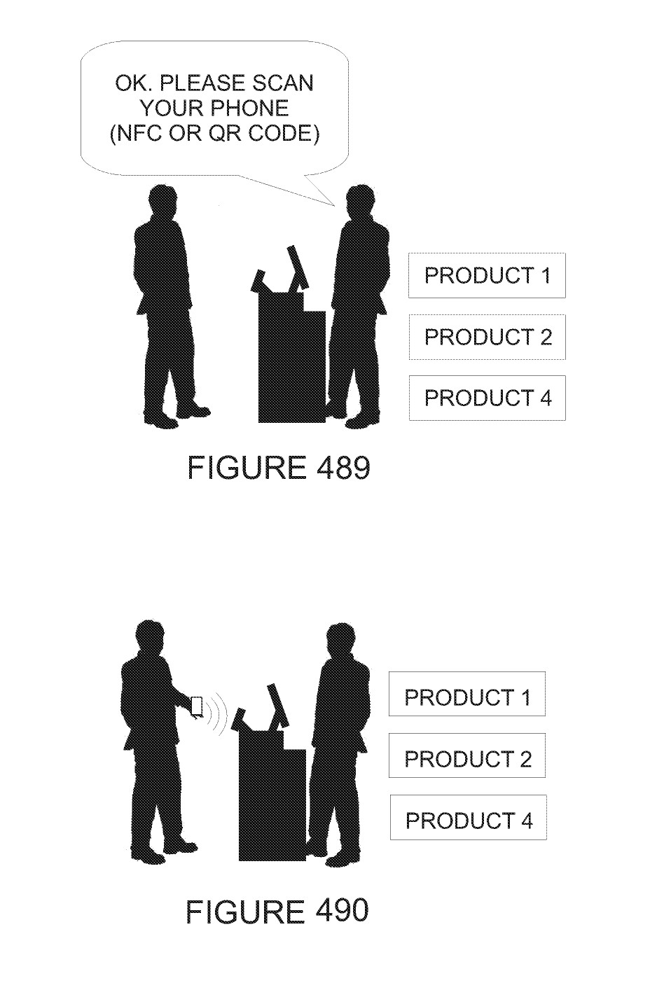

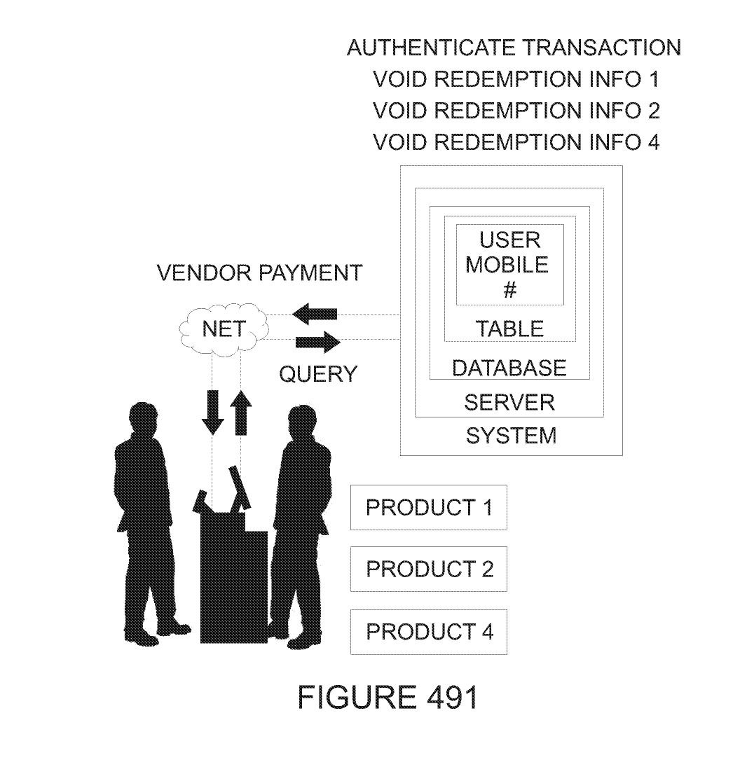

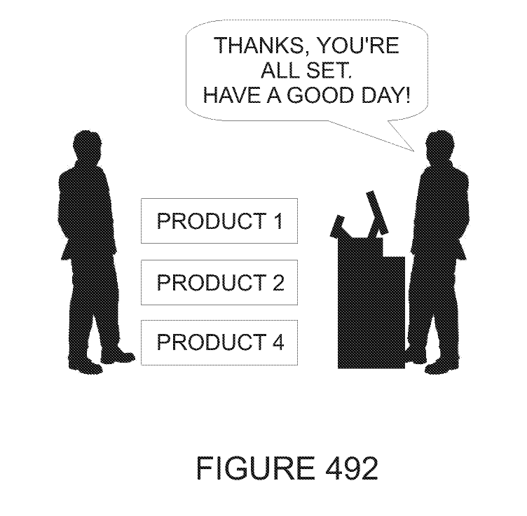

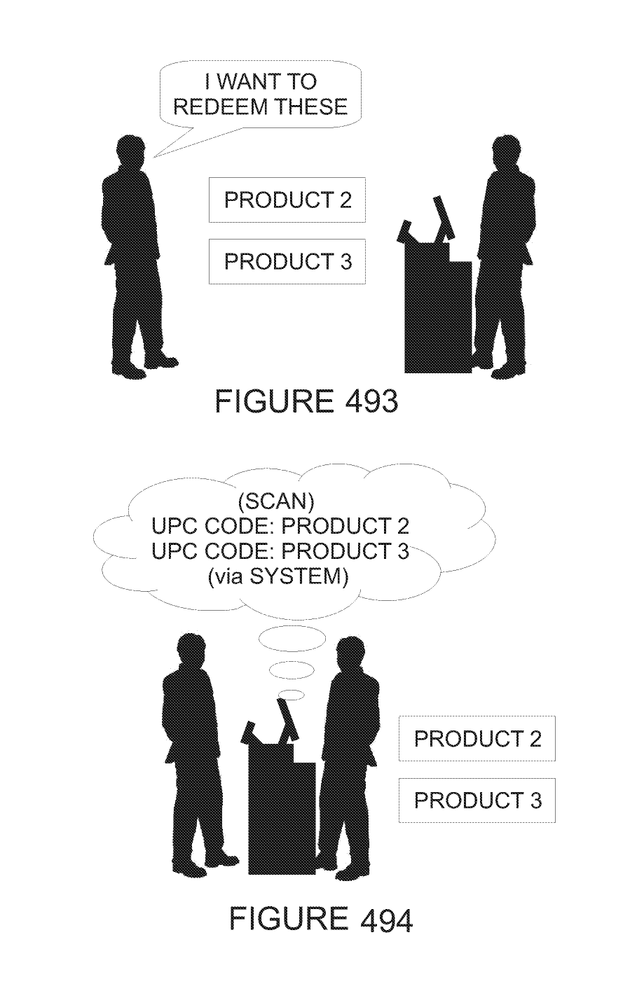

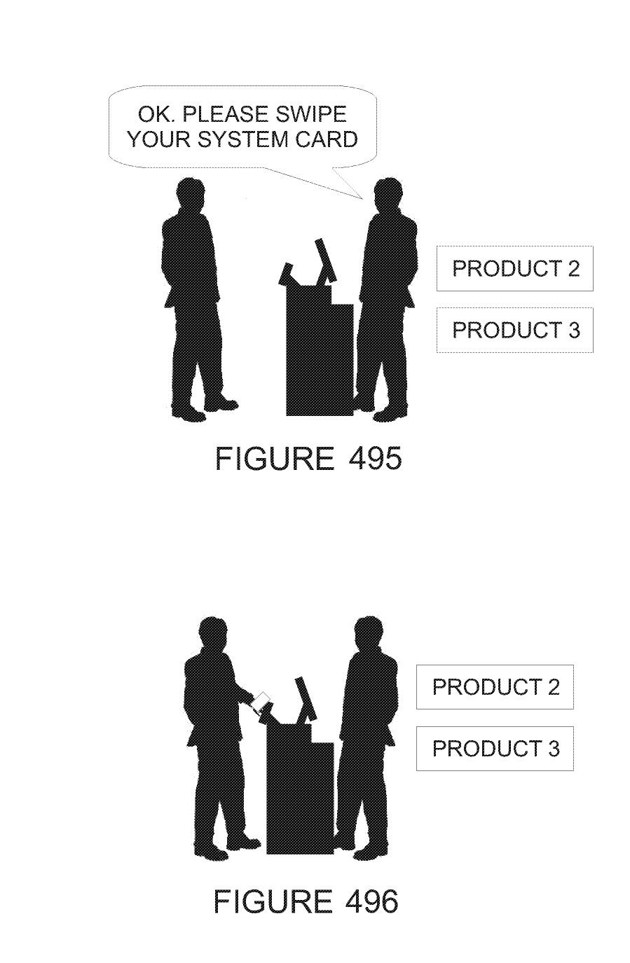

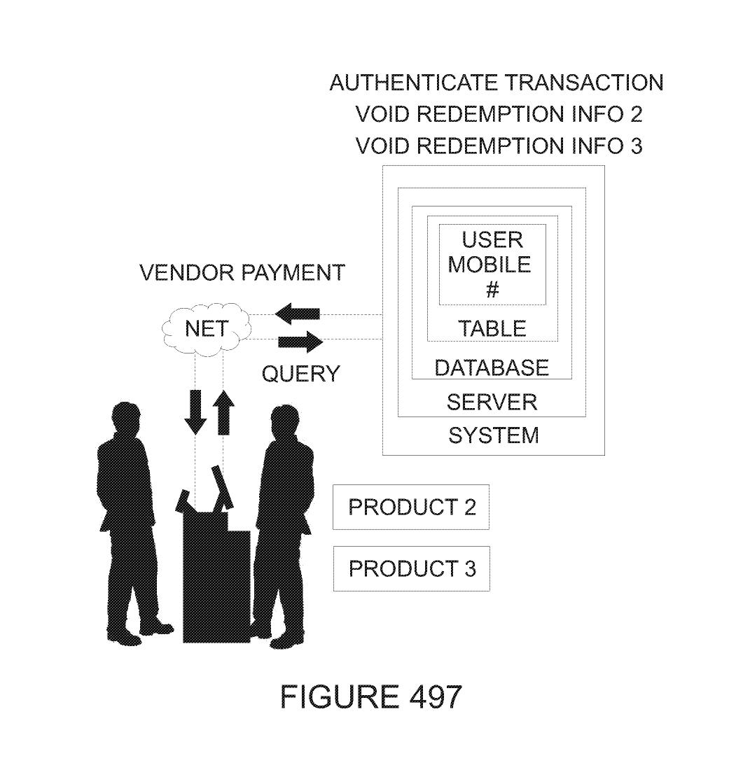

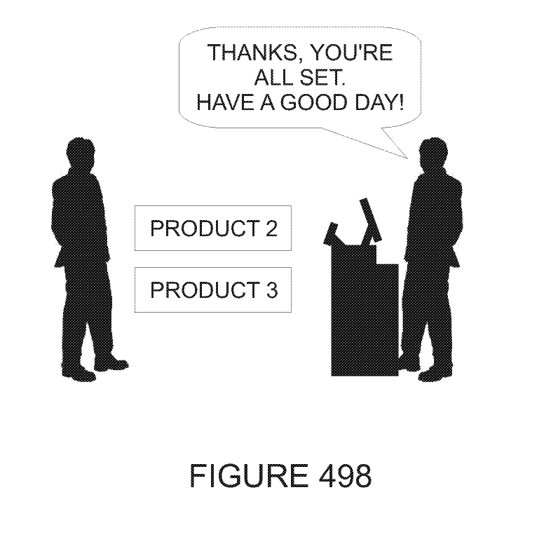

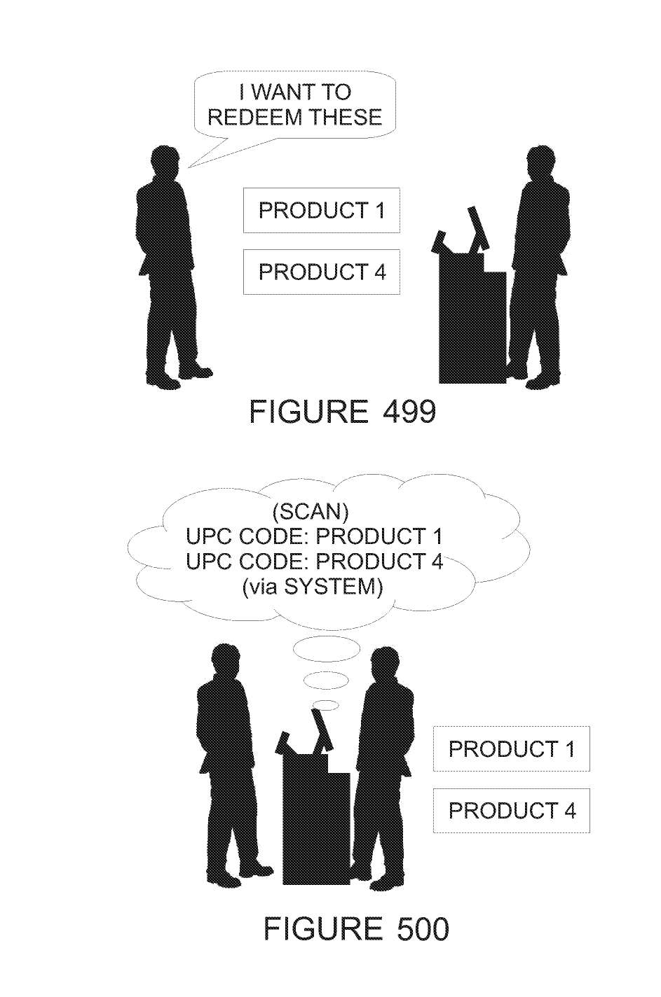

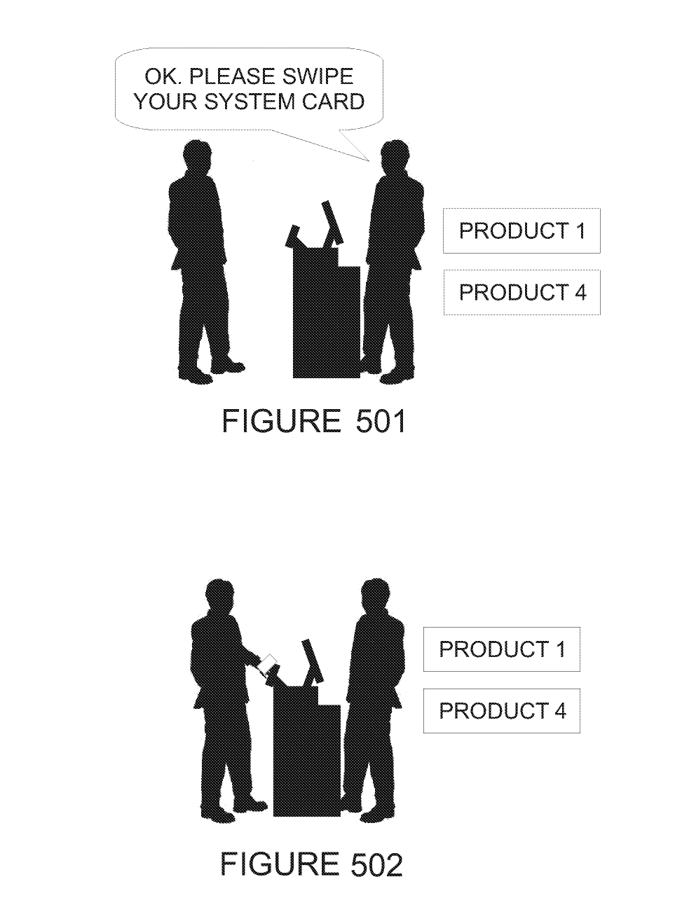

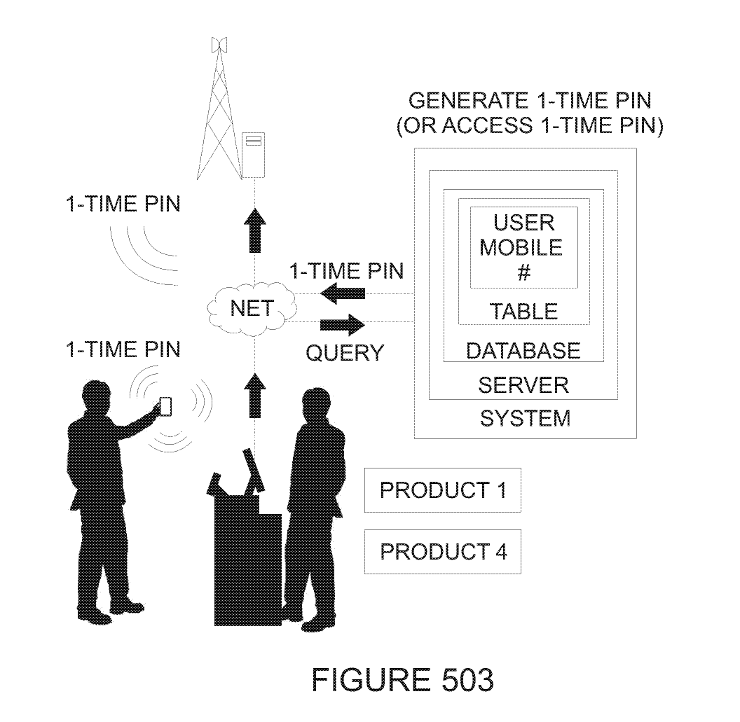

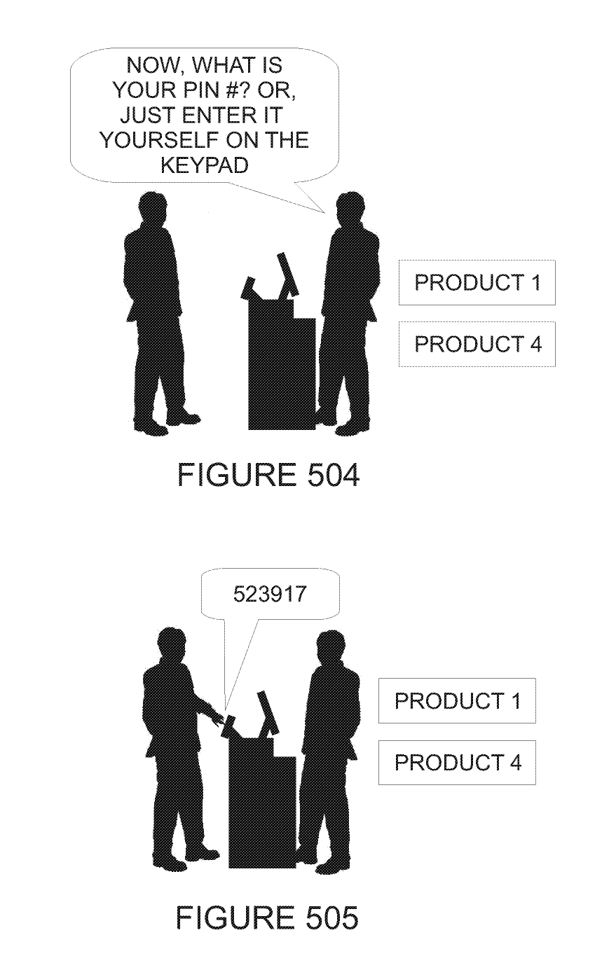

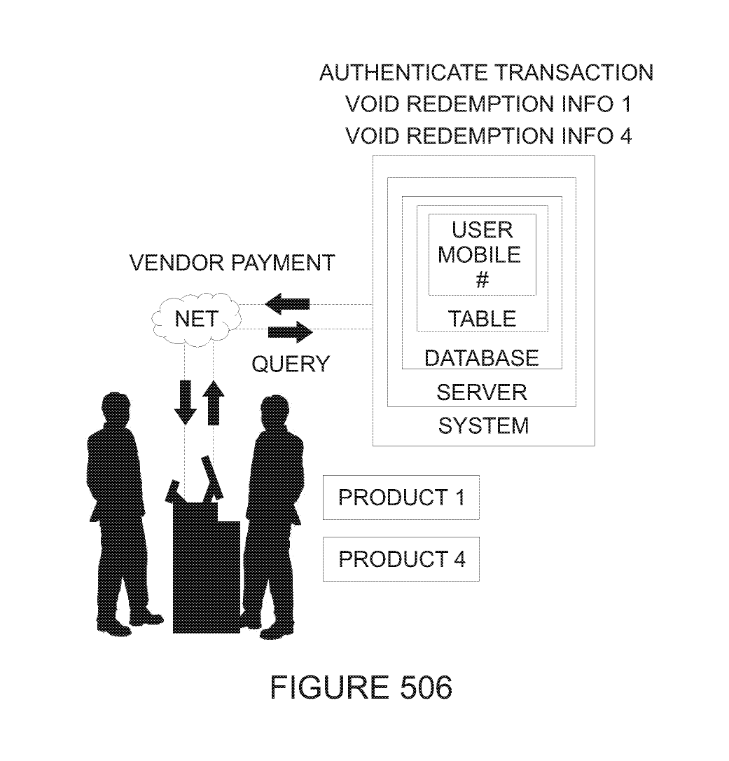

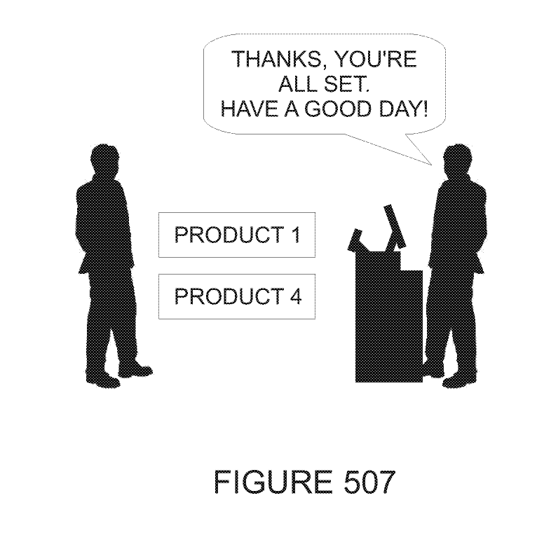

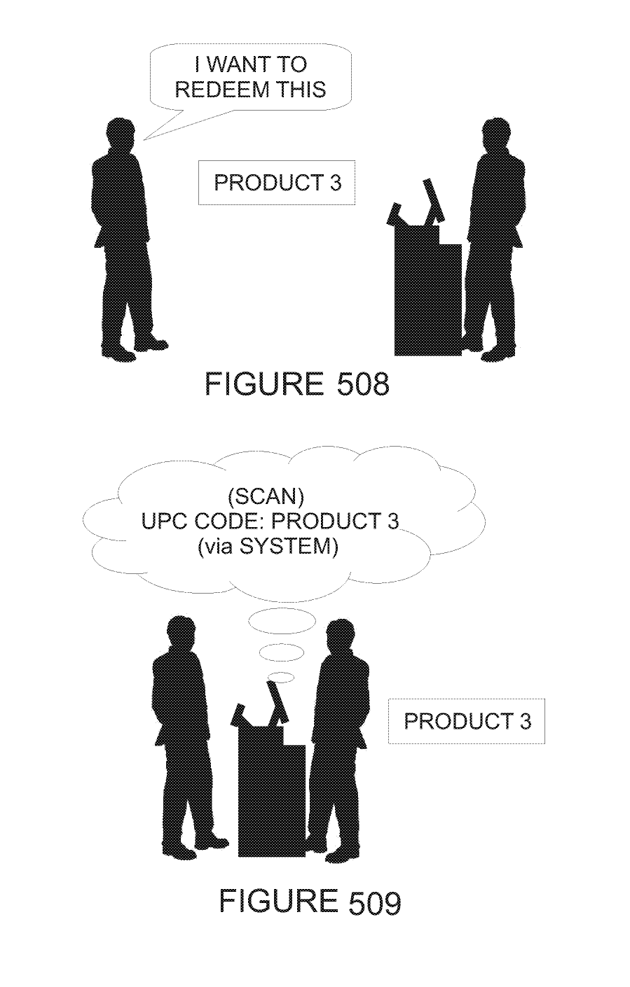

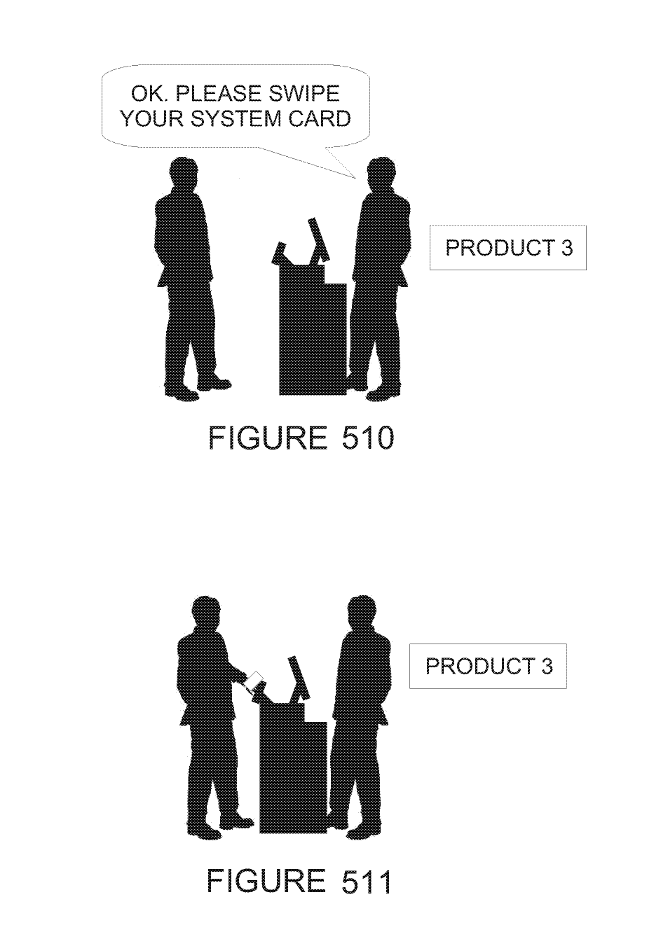

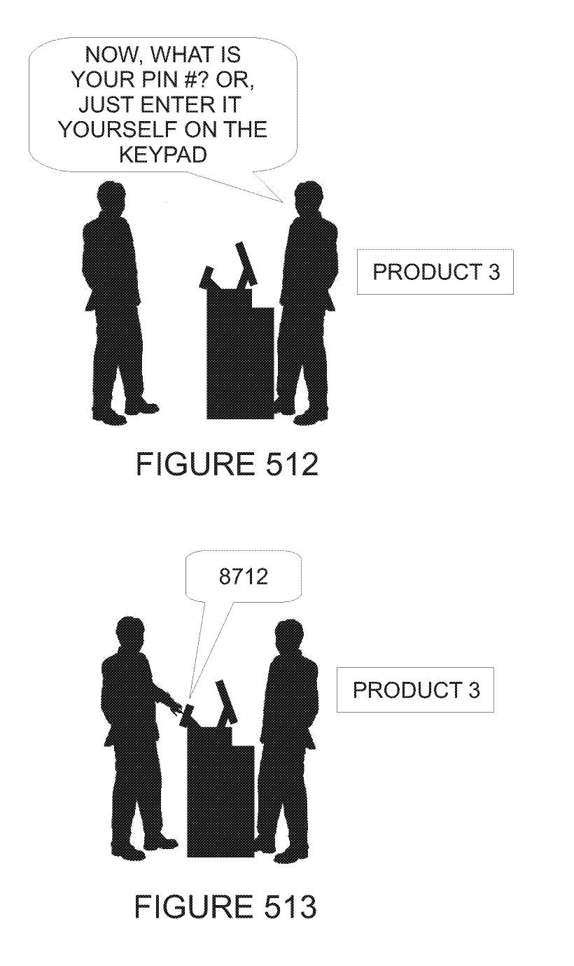

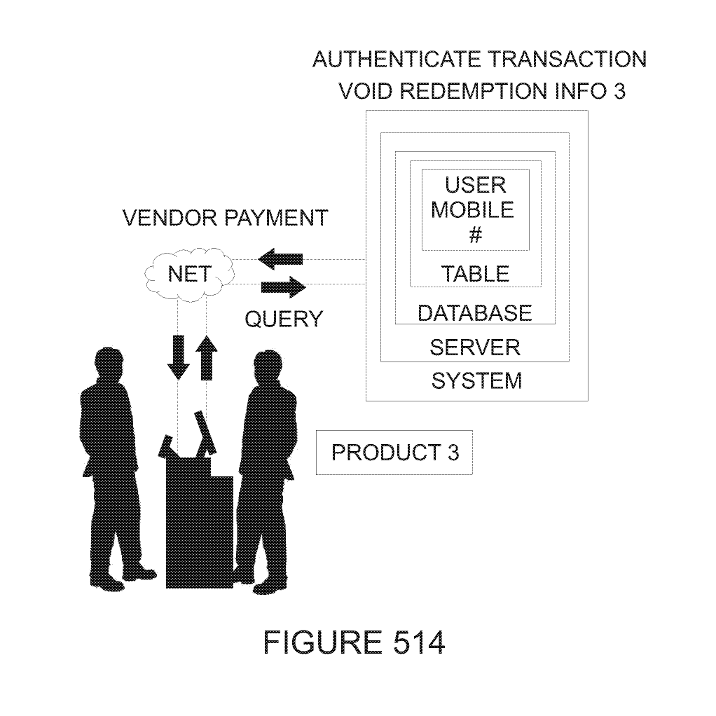

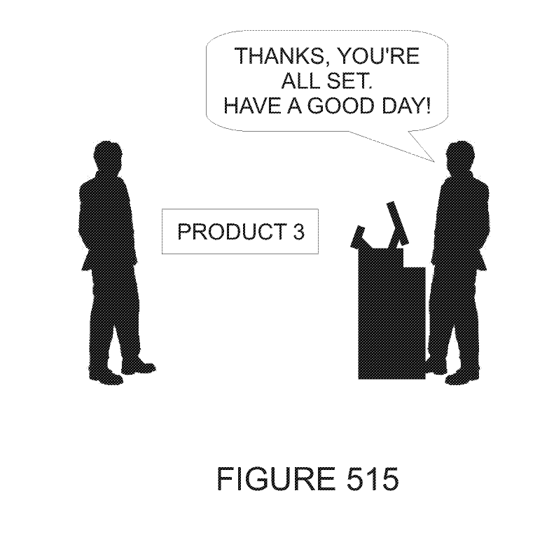

According to some embodiments, the inventive technology may allow an individual to perform various transactions while at a point of sale (see, for example, FIGS. 1-455 of U.S. Provisional Patent Application No. 62/040,402, which are not shown in the appended figures, but which are hereby incorporated by reference in their entirety). For example, according to some embodiments, the inventive technology may allow an individual to send things to one or more other individuals while paying at a point of sale, without limitation. For example, a user may simply provide one or more recipient electronic addresses (e.g., a mobile number, an email address, or a social media handle, without limitation) to the store employee, and the user may indicate which items/products/goods/services are to be sent to the respective provided one or more recipient electronic addresses, and may pay for it normally, but may not receive the respective items/products/goods/services; wherein the one or more recipient electronic addresses may receive redemption information 64 equivalents of the respective items/products/goods/services paid for by the user, without limitation.

A user 91 may indicate which items he/she would like to send, and provide this information to a person manning the register, along with instructions and at least one recipient electronic address. The user 91 may pay for the items normally, for example, using system credit, cash, debit card, credit card, gift card, gift certificate, coupon, pre-paid voucher, rewards points, other payment data 10, and/or the like, without limitation. The user 91 may not receive the items, but rather, the person manning the register may deliver the items to the end user(s) 92 affiliated with the at least one electronic address, electronically, using a system platform and/or components thereof (e.g. “text” messaging or via payment terminal software 147 and an interface 106 provided to the payment terminal, without limitation). In some non-limiting embodiments, system software 147 (e.g., a system API, script, macro, add-on, app, or other program/software) and/or hardware (e.g., reader means, scanning means, etc., where appropriate) may be operably installed, configured, and/or coupled to the register, in order to facilitate the electronic delivery of the indicated and paid for items to the end user(s). In this regard, a person at the register may, in some embodiments, press a “system” or equivalent “promotional” or “gift” key on the register, and may add the items to a user's receipt 20, for example, to segregate items, products, goods, or services to be physically provided to the user, from items, products, goods, or services which are to be electronically delivered to the desired recipient(s). QR codes, 1-D or 2-D barcodes, audio data, and/or the like may be electronically created, sent, and/or electronically delivered using the system platform, to one or more electronic addresses (e.g., email address inboxes, to a mobile phone application, to a browser 131 (e.g., via a website using IP address information and/or a GUID), to an SMS or MMS inbox, to a social media-based direct messaging inbox, and/or the like, without limitation), for example, to speed the process of manually entering redemption codes during use/redeeming, without limitation. In this regard, a person manning a register may, during a redemption process, only need to scan/read/automatically process a code using hardware and software, instead of manually/physically entering it using a user interface 106, without limitation. In some embodiments, multiple pre-paid items, products, goods, or services may be combined into a single redemption code—regardless of whether the code is: a numerical or alphanumeric redemption code; an image code such as a one or two-dimensional barcode, 2D data matrix code, or QR code; and/or an audio-based code comprising audio data 7, without limitation. For example, in some embodiments, the single redemption code may comprise a plethora of coded and/or encrypted portions of user data 8, purchase data 9, payment data 10, redemption data 64, types 72 of redemption data 64, and various combinations of information (e.g., metadata 90), without limitation. In some embodiments, the single redemption code may be scanned or otherwise entered into and/or received by a payment terminal/register (e.g., via payment receiving means 100, scanning means 102, audio input means 103, data disk reader means 115, reader means 110, data input means 112, image capture means 116, and/or the like), without limitation. In some embodiments, after a single redemption code is scanned or otherwise entered into and/or received by a payment terminal/register, the single redemption code may be voided, items pertaining to the single redemption code may be exchanged for the single redemption code, and the recipient wishing to redeem the single redemption code may leave with the items. Alternatively, an electronic computing device 95 (e.g., a tablet or kiosk 3, without limitation) may be provided adjacent the payment terminal or register, or may make up a portion of the payment terminal or register, or may essentially comprise the payment terminal or register, without limitation. The electronic computing device 95 may have access to a network 118 (e.g., via network 118 connection means 101, 112). The electronic computing device 95 may be configured to communicate with a system-integrated database 129, 135, 137, 138, for example, via a customized system-vendor software package 147, and/or via the system website 127, without limitation. The vendor, when logged into the system (e.g., via a vendor portal user interface 106), may have access to profile 130 information. While logged into the system via appropriate system components, the vendor may enter redemption codes into fields provided on a user interface 106 communicating with the electronic computing device 95, or may scan codes contained within printed emails, emails displayed on a redeeming user's tablet or phone, or text messages displayed on a redeeming user's tablet or phone, which may have been electronically delivered via the system platform, sent from a system electronic address, or forwarded between users, without limitation. In some embodiments, components of the system may be universally accepted, practiced, and/or used across a plethora of participating entities 65, wherein redemption information 64 may be adjusted, modified, and/or customized to accommodate a participating entity's needs, without limitation. A participating entity 65 may, for example, upon a consulting meeting with system representatives, discuss what format(s), delivery method(s), and/or redemption mechanism(s) would work best with their existing payment hardware and/or software infrastructures, without limitation. System software 147, structures, and/or architectures (e.g., database 129 architectures) may be adjusted, modified, and/or customized to accommodate the preferred format(s), delivery method(s), and/or redemption mechanism(s), without limitation.

According to some embodiments, a user may add things to their registry; for example, by providing the appropriate item code or numerical barcode number, along with the word, “like”, without limitation. According to some embodiments, a user's registry may be portable, and/or universal in nature. According to some embodiments, a user may not need to be an existing member, subscriber, club member, or user of a third-party, such as a vendor/selling entity 65 or a social network 95, in order to benefit from the inventive features and concepts disclosed. According to some embodiments, a user may not need to have an existing profile 130′ with a third-party, such as a vendor/selling 65 entity or a social network 93, in order to benefit from the inventive features and concepts disclosed. According to some embodiments, system API's and/or integration software 147 may be installed on third-party hardware (e.g., drives), operating systems, and/or software, without limitation. According to some embodiments, system API's and/or integration software 147 may be integrated with existing third-party platforms and/or third-party infrastructures to form a larger system infrastructure. According to some embodiments, the system infrastructure and/or components thereof may be advantageously employed and/or utilized by components of the system to maximize awareness of items, products, goods, or services, awareness of promotional events, awareness of specials, awareness of drives (e.g., food drives, where users can donate one or more canned goods with a text, email, social media post, and/or a short phone call or call-and-hang-up action, and/or the like), without limitation. According to some embodiments, the system infrastructure and/or components thereof may be advantageously employed and/or utilized by components of the system to maximize revenue from advertising (for example, using the system's proprietary vanity item codes, which may be purchased, licensed, and or “owned” by participating entities 65), without limitation. For example, rather than asking “Do you want fries with that?” or “Would you like to upgrade the size of your meal?” a fast food franchise may ask “Would you like to send1?” in order to maximize incremental sales and/or “up selling” at a point-of-purchase. Moreover, users of the system may be more inclined to make impromptu or impulsive purchases at a convenient time, rather than following up with an online or physical transaction at a later time. One advantage of certain embodiments of the inventive technology, is that email and text, as well as UPC codes, are simple to use and are ubiquitous, and may therefore allow individuals with little technological sophistication or know-how, to learn and identify what their contacts want, and be able to purchase it for them quickly, with little effort, for example, during an electronic conversation (e.g., within an email chain, forum post, social interaction, video web chat, or text messaging conversation), without limitation. In some embodiments, users 91, 92 may clear their registry(ies), for example, with a “clear” command, or the like, without limitation. In some embodiments, users may “unlike” specific items on their registry(ies), for example, using a “bye” command or the like (such as an arbitrary equivalent thereof, such as an “unlike” command), along with an input 4 comprising the previously liked item or item information (e.g., a previously liked system item code, UPC code, or the like). Similar functions may be performed through a user interface 106 of a kiosk 3 and/or mobile application 147 such as a system-specific mobile application 147 or a system-integrated third party mobile application, without limitation. In some embodiments, system components (e.g., system software 147) may be configured to instantaneously remove a previously liked item, product, good, or service from a person's registry(ies), for example, once the person receives the liked item, product, good, or service from someone else through the system platform (e.g., a first user may purchase and gift a liked item of a second user, and the system software 147 may check the database 129 to see if the gifted item, product, good, or service was previously liked by the second user, and if so, the system software 147 may modify profile information 130 of the second user so as to remove the previously liked item, product, good, or service which has been purchased by the first user 92 and gifted to the second user 92, without limitation). Such a built-in system comparing function may prevent double-gifting situation, wherein multiple users may be inclined to gift similar or identical liked items, products, goods, or services found on a user's registry(ies). Such preferences may be set via the system website 127 (e.g., while logged into a private account), by calling a system customer service representative, and/or by sending an instruction to a send1 electronic address (e.g., by texting or emailing the command “Likepreference1” or ““Likepreference5” in a request communication, wherein a list of like preferences and other commands are provided on the send1 website or third party site). In some embodiments, separate wish lists may be used, for example, wherein a system “like” list or “favorites” list of a user (or the like) may be representative of a lasting archive of one or more items, products, goods, or services of which the user has a favorable opinion of; and wherein a “gift” or “wish” list of a user (or the like) may be representative of a temporary list of one or more items, products, goods, or services of which the user wishes to have purchased for them. A nice advantage of the system over other social platforms, is that a user of the system's various favorable opinion features may be far less prone to “over-share” and/or “like and share everything” they contact or connect with. Rather, users of the system's various favorable opinion features may probably be more likely to choose to like and/or indicate only items, products, goods, or services they “really truly want” (e.g., for a holiday, birthday, graduation, retirement, wedding, special occasion, etc.). In other words, some embodiments of the system's “like,” “favorites,” “wish,” “add,” and/or “gift” features may be thought of as a more practical permanent or temporary record of what may be precious to a system user 91, 92, or what a system user frequently uses, rather than a noisy list of likes or “flavor of the day” shares which are all too common on social media platforms. According to some embodiments of a system platform, gifts, for example, in the form of electronically-delivered redemption information, may be instantly redeemed by in-store pickup—avoiding the wait, hassle, time expenditure, and/or financial expenses of delivering items through mail or in person. In this regard, recipients may receive quicker gratification—(e.g., sharing their new toy, watching their new DVD, enjoying their new movie rental, playing their new game, registering for an event early or just before an entry deadline, and/or utilizing received system credit in a different manner). In some embodiments, uses of the inventive technology may include parents providing their children (e.g., who may be away attending college) with money for food and other things such as books. According to some embodiments, uses may include family members placing redemption information (e.g., a handwritten redemption code and/or PIN, or a printed email or web page confirmation print-out containing redemption information 64) in a greeting card, instead of cash or a check that needs to be cashed and/or cleared. According to some embodiments, uses may include grandparents sending their grandchildren a text or email containing redemption information 64, via the system (e.g., in some embodiments, a user-defined user-created arbitrary “vanity” electronic address, such as “grandkids”, without limitation, may contain multiple electronic addresses corresponding to multiple respective grandchildren, wherein as little as a single electronic transaction request message comprising the user-defined “vanity” electronic address as an intended “recipient” may be required to conveniently allow a grandmother to perform the same gifting transaction for all of the grandchildren, simultaneously, without multiple transactions being performed on the front end of the transaction). According to some embodiments, going away presents or maternity presents for co-workers at the office may be made easier with the inventive features and concepts. According to some embodiments, gift pools may be as simple as one person sending funds or credit (e.g., redemption information 64) to a recipient's electronic address, using system components and inventive protocols, on behalf of a group of individuals; wherein each of the group of individuals may, for example, send reimbursement funds or credits to the electronic address of the person sending the funds or credit to the recipient's electronic address, via the system, without limitation. In such a scenario it is envisaged that in some embodiments, each of the group of individuals may send a respective portion or share of the reimbursement funds or credit to the electronic address of the person sending the gifted funds or credit to the recipient's electronic address, via different platforms (e.g., via text messaging (e.g., SMS, MMS, mobile messaging), via email, via social media platform, via web submission, via phone call, and/or the like), without limitation.

In some embodiments, to see what someone (e.g., a friend, contact, relative, co-worker, and/or acquaintance) likes, a user may, in an electronic request communication to the system, provide the person's electronic address (e.g., mobile number, email address, or Twitter handle, without limitation), along with the command “peek” (or the like, e.g., “spy,” “look,” “read,” etc.), without limitation. This may be observed in the non-limiting exemplary embodiments shown in FIGS. 570-574.

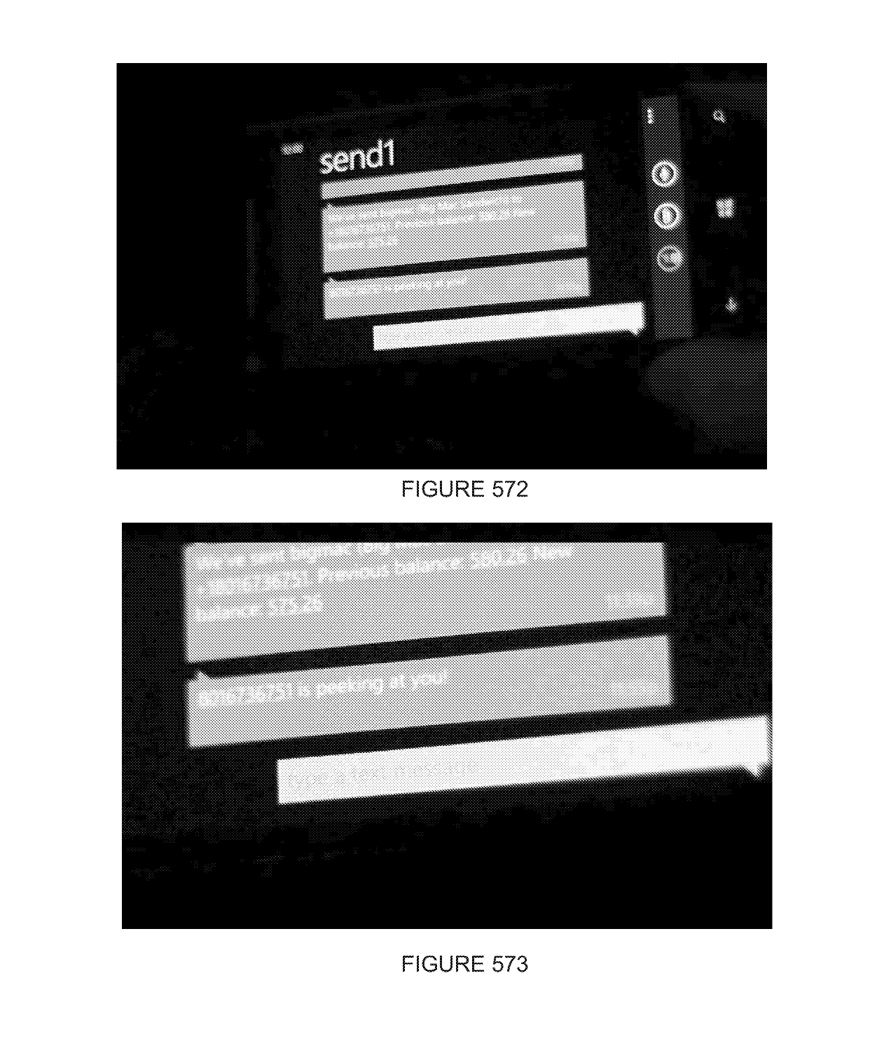

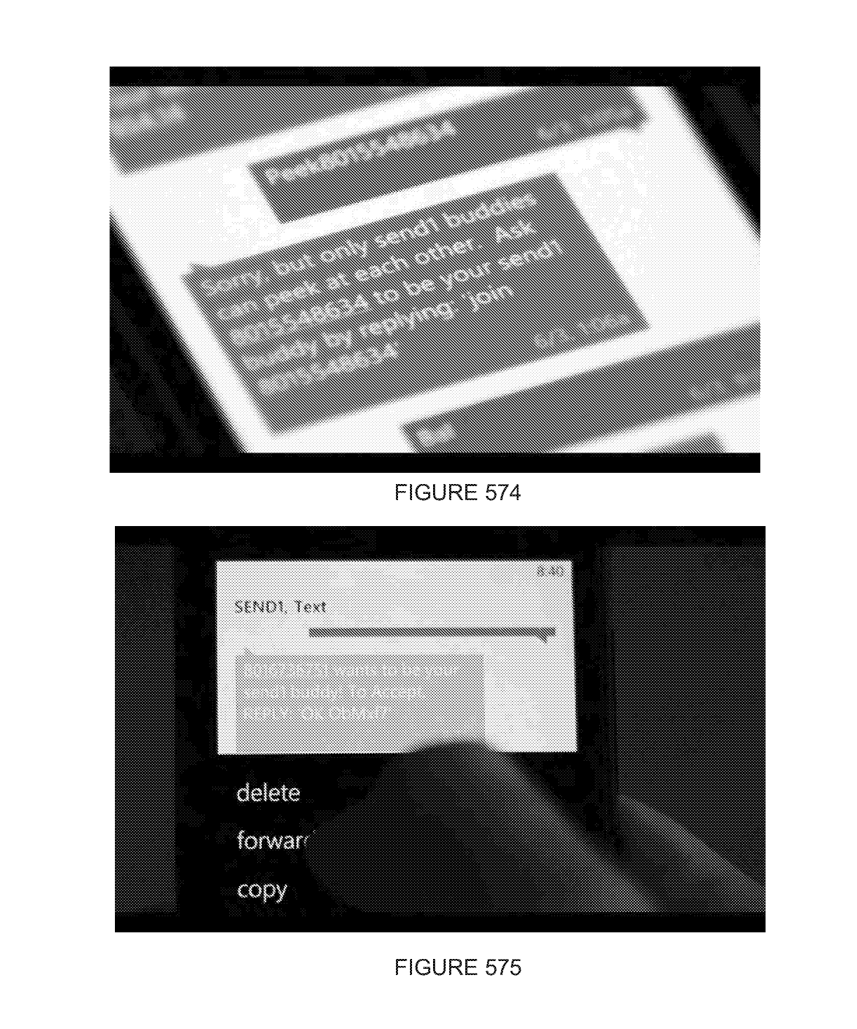

In some embodiments, a user's registry(ies) may be seen by everyone using the “peek” command in conjunction with an electronic address (e.g., as shown in FIG. 570, a mobile number such as a 10-digit mobile number for U.S. and Canada such as “248875334.5”, without limitation, and which may comprise a different length and/or format for mobile numbers of other countries). However, in more preferred embodiments, only “buddies” which may have been pre-vetted, requested, and/or may otherwise have been accepted, may view a person's registry, as the nature of such a feature may be thought of as being a private, or personal feature (see, for example, FIGS. 574-579 which are in no particular order). FIG. 571 suggests a non-limiting output 5 of the system which may be provided upon a user providing a “peek” request to the system for a mobile number electronic address “8015548634”, without limitation. FIGS. 572 and 573 suggest a non-limiting output 5 of the system of a user having a mobile number electronic address “8015548634” being spied upon by a user having a mobile device number electronic address “8016736751”, without limitation. Other types of electronic addresses described herein may be utilized, without limitation. According to some non-limiting embodiments, if a person's electronic address (e.g., mobile number, email address, and/or social media handle) is used in a “peek” request (or the like), the system software 147 may, in some embodiments, let the relevant person(s) know, for example with a message along the lines of “[requesting user's electronic address] is peeking at you”, wherein the variable [requesting user's electronic address] may comprise the requester's electronic address, as shown in FIGS. 572 and 573, without limitation. It is anticipated by the inventor that other types of equivalent messages and/or additional features may be provided which fall within the spirit of this disclosure. In some embodiments, system components may not provide a notification of being “peeked at” or otherwise “spied upon” by other users. In such latter cases, anonymity may be preserved and/or the mechanisms of the system platform may be kept even simpler. Embodiments of the inventive technology may make personalized gifting as easy as it can be, as well as convenient (or at least as convenient as sending one or more SMS messages, emails, and or social media posts), without limitation.

In some embodiments, a user may send a “friend” or “buddy” request communication to a system electronic address, which may comprise the keyword command “join”, or the like (e.g., “add,”), and at least one electronic address, without limitation. Again, as previously stated, such a command may be similarly performed with a mobile application 147 interaction or website 127/web-based environment interaction, for example, by interacting with icons, indicia, instructions, buttons, scroll bars, input fields, and/or the like, which may be provided to a user interface 106 or browser 131, without limitation. In some embodiments, users may confirm “friend” or “buddy” requests, for example, by replying as instructed or otherwise prompted by an electronic communication from the system, without limitation (e.g., as suggested in non-limiting FIGS. 575-577).

In some embodiments, users 91, 92 may provide the keyword “join” (or the like) in an electronic communication to the system, for example, a user 91 may send an email request message to a system electronic email address, the email request message containing one or more electronic addresses (e.g., email address, mobile number, or social network profile ID (e.g., Twitter handle or Facebook ID number)) of one or more contacts, friends, or relatives 92 of the user 91, the email request message further containing the word “join” (or the like) or equivalent command or instruction. System software 147, upon receipt of the email request message, may deliver one or more confirmation request messages to each of the provided electronic addresses, via the respective platform associated with the provided electronic addresses. A confirmation request message may, as a non-limiting example, ask or prompt a recipient of the confirmation request message, if he/she wants to approve the request, and may comprise one or more instructions on how to accomplish the task (e.g., “ . . . Reply “Y” for yes, “N” for no, “H” for help, “O” for opt-out”, without limitation). For example, in some embodiments, a simple reply communication acknowledging the requesting user electronic address as a “friend” may be sent back to the system to confirm a buddy request. In some embodiments, system software 147 may generate a one-time password, as a security token to be used in a buddy request approval process. This token may, for instance, be stored in a “friend pending” database 129 table (or the like), along with the requester information and the recipient (i.e., “potential friend”) information. A recipient user approving the buddy request may send a reply message to a system electronic address (or simply reply to the received confirmation request message) with an acknowledgement electronic message comprising the the token, or, for improved platform robustness, may require the command “ok” to be used in conjunction with the secure token in the acknowledgement electronic message, wherein the “ok” command may be parsed and used to identify the token as a “friend pending” database table pointer, without limitation. In some other embodiments which may not be illustrated, a user may reply with a keyword such as “ok”, along with the requesting user's phone number as a double-confirmation/redundant confirmation. If the token and/or incoming electronic address is recognized by the system as a “pending” friend request between the two users, the friend/buddy request transaction may be confirmed and finalized, and the two users may be joined as system “friends”, for example, within one or more database tables containing profile 130 information of both users, without limitation. In some embodiments, no security tokens may be necessary (e.g., if using a mobile application 147 after establishing sign-on credentials, and a secure communications link, without limitation).

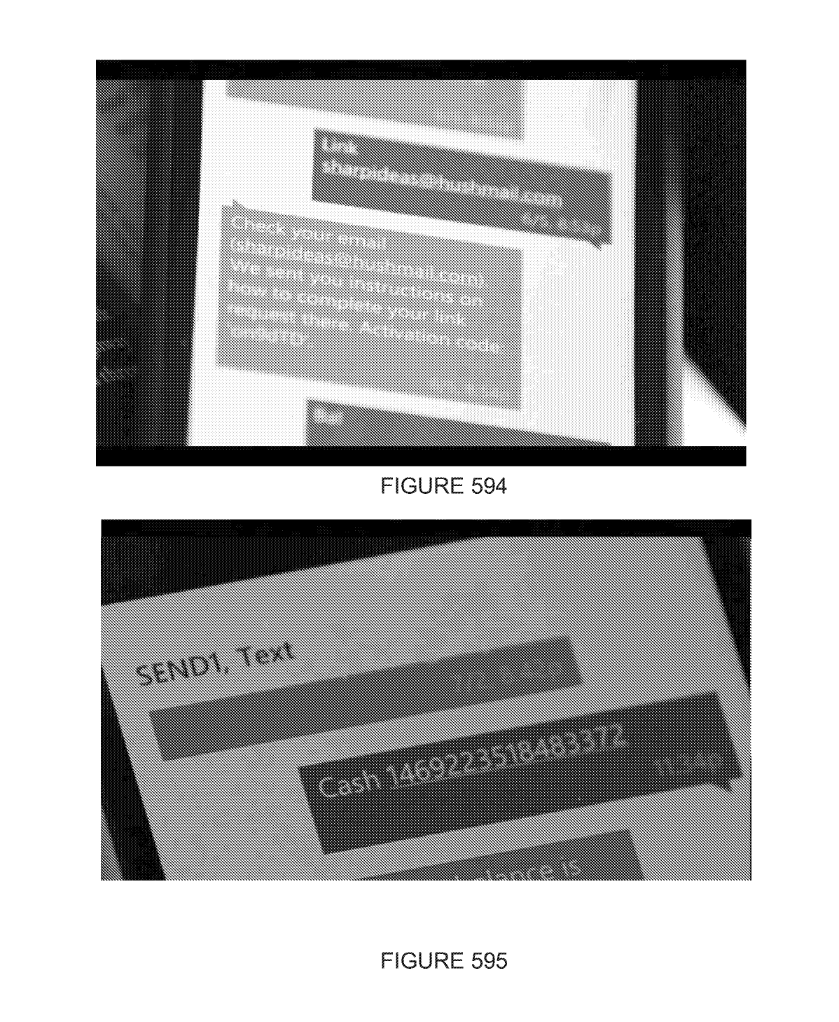

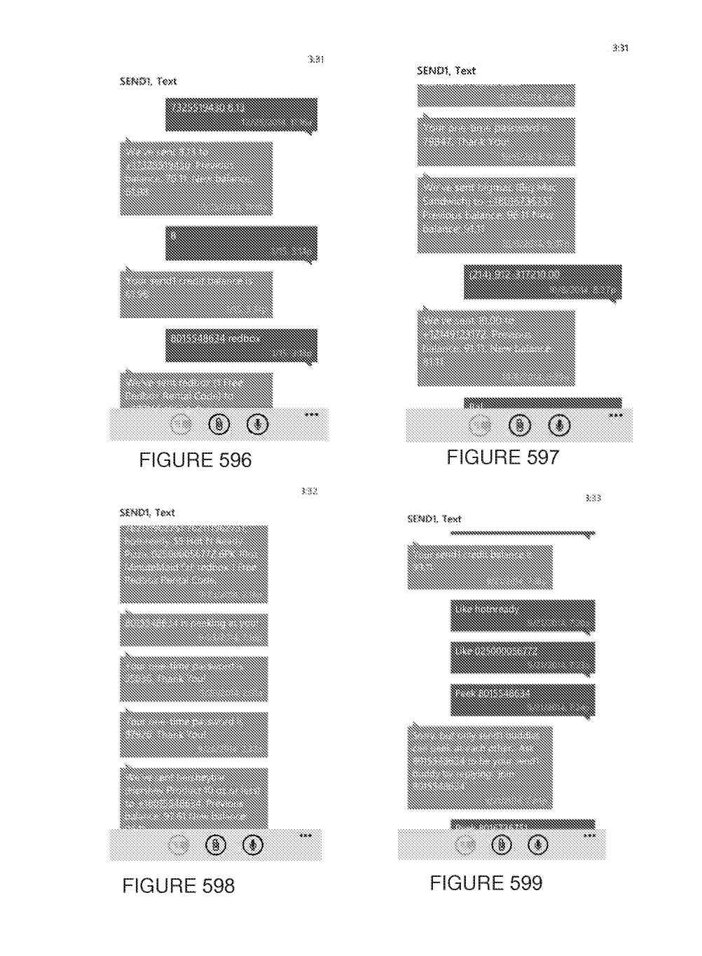

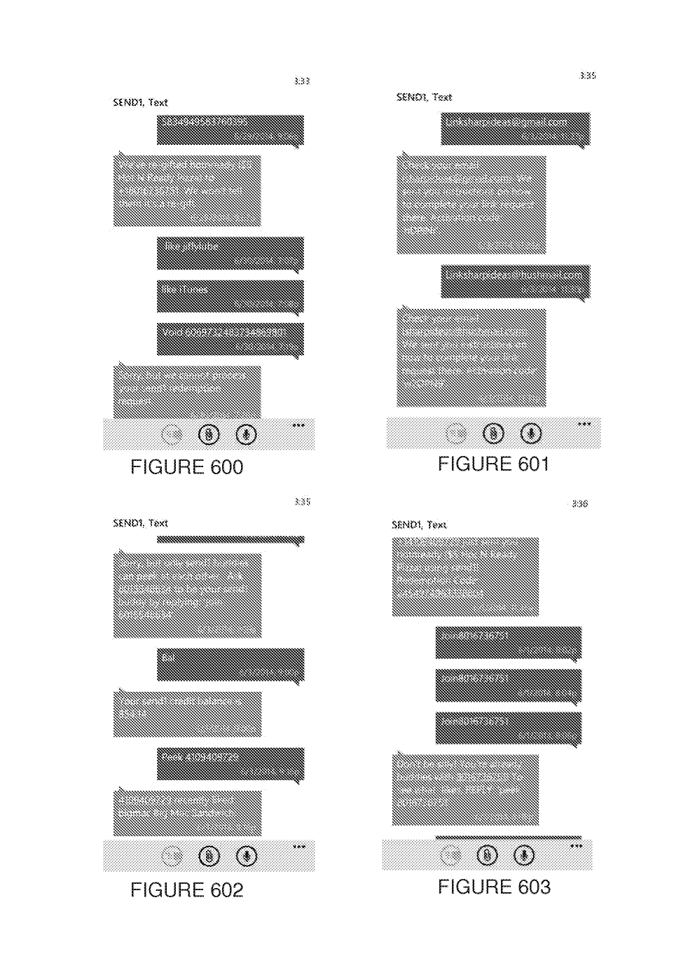

In some embodiments, and as may be appreciated from code listings in the abovementioned related co-pending applications, users 91, 92 may provide the keyword “link” (or the like, e.g., “add”) in an electronic communication to the system to link separate system accounts (and consolidate account funds into a single account balance) and/or to add an electronic address to their system account. For example, if a user's email address is not active with the system, but the user's phone number is active with the system (i.e., not in a system database 129 or otherwise not linked with the user's email address), and the user wishes to utilize the inventive features and concepts of the present technology with his/her phone number, the user may submit an instruction in an email to the system, the email comprising therein, a “link” command (or the like), as well as the person's phone number, mobile number, and/or social network profile ID (e.g., Twitter handle or Facebook ID number), without limitation. The system, upon receipt of the email request, may send one or more electronic communications to the respective provided phone number, mobile number, and/or social network profile ID with further instructions regarding how to confirm the request and ultimately link the requested electronic addresses to the same system profile 130, without limitation. FIG. 594 shows one non-limiting example of a user who has an active phone number electronic address on file in a system profile 130, but wishes to add his/her email address to the profile 130, wherein simple instructions are provided via both phone-based and email/web-based platforms to complete the transaction request.

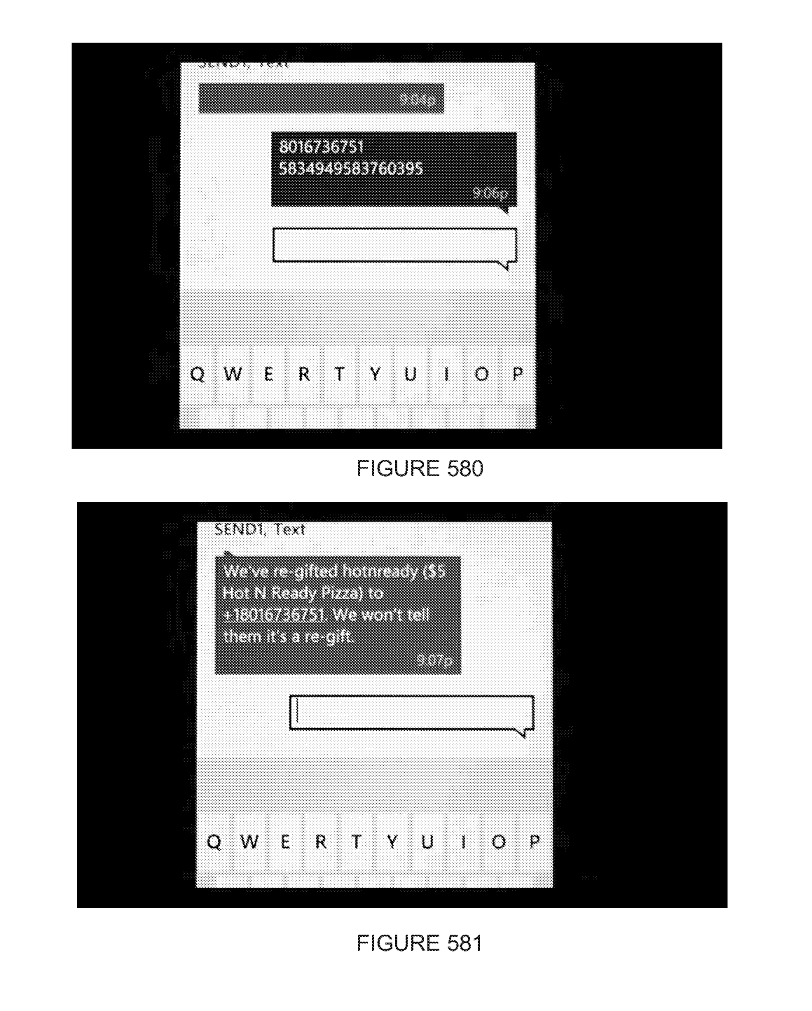

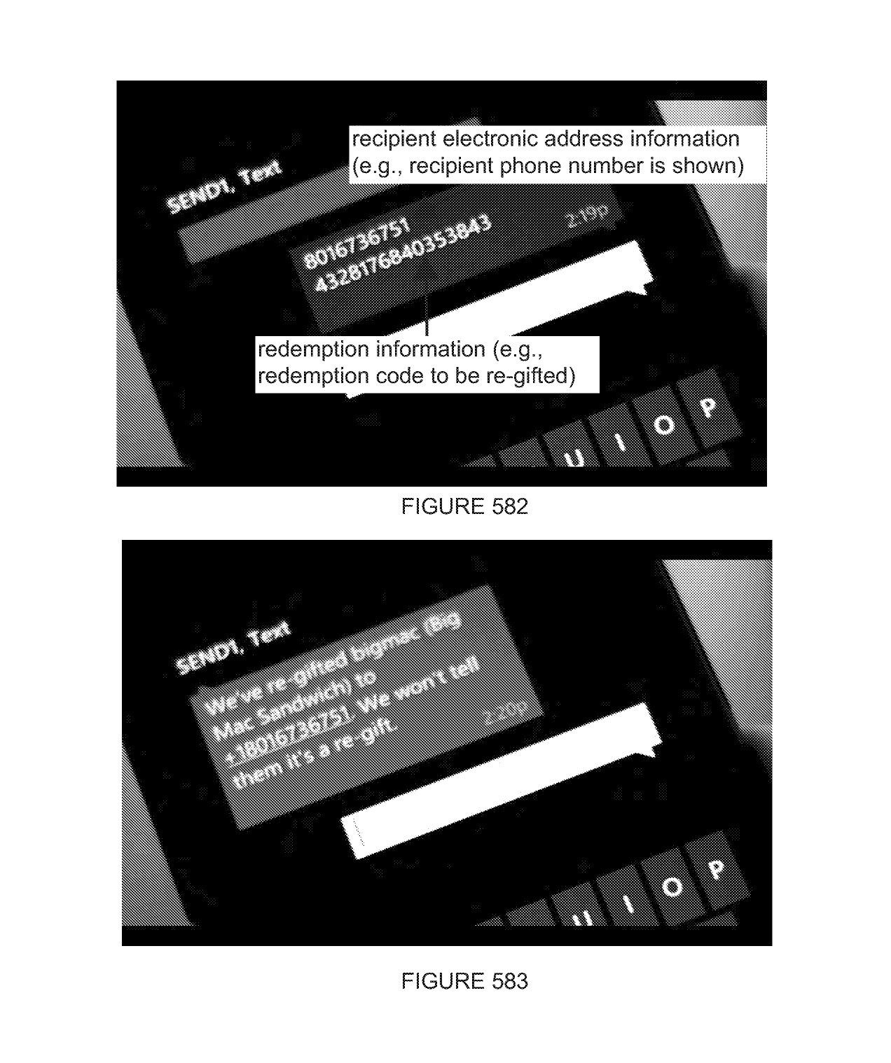

In some embodiments, if a user receives something they might not like, or if a user feels they have too many unused redemptions, the user may re-gift redemption information 64, with, or without penalty, for example, by sending a communication to the system (e.g., an electronic communication comprising text-based instructions, image-based instructions, audio-based instructions, tactile, movement-based, and/or gesture-based instructions which may be interpreted by system software as one or more instructions to “re-gift”). According to some embodiments, the system may, or may not electronically or physically notify recipients when gifts (e.g., in the form of redemption information 64) received by the recipients have been repurposed by a sending user. This may be appreciated from non-limiting FIGS. 580-583, without limitation. It should be understood that while the particular shown embodiment involves a redemption information 64 in the form of a received redemption code (e.g., copy and pasted from a received electronic message from the system), a user may instead provide an item code, UPC number, and/or the like, the system software 147 may determine if the user has redemption information 64 pertaining to the provided item code, UPC number, and/or the like, and the system software 147 may void the respective redemption information 64, create new redemption information 64, and send the new redemption information to the desired recipient. In some more crude embodiments, a user may simply forward a message containing redemption information 64, to one or more other users, for use by the one or more other users, particularly, in instances where the redemption information may be transferable, without limitation. In some more crude embodiments, a user may copy and paste redemption information 64 into various communication forms, and deliver it to one or more other users via said various communication forms, for use by the one or more other users.

In some embodiments, users may re-gift by using a received redemption code, in lieu of/in place of an item code or amount of credit to be sent. System components may check, parse, address any vulnerabilities to SQL injection and other hacks/attacks, remove extraneous characters, re-format user inputs 4 into a useable form, and/or may convert text, such as item codes and/or other user inputs 4 to lowercase form or upper case form, before processing information gathered from incoming requests, using various string manipulation algorithms. In this regard, platform robustness may be improved. In some embodiments, if system components notice that an item code matches an unused redemption code in its database, its algorithms may recognize that nothing is being purchased, gifted, or sent (e.g., credit). This may be done by checking the number of characters, by checking the number and/or arrangement of alphanumeric characters, or the like. Accordingly, in such instances, system components may recognize a message containing only a redemption code as a request to void the redemption code, and system components may void or remove the redemption code from the requesting user's account. In some embodiments, a re-gifting process may involve the steps of system components re-generating redemption information 64, for example, by creating a new redemption code, and sending the new redemption code to the new recipient (e.g., an electronic address who is to receive the re-gift, by virtue of a requesting user's instructions/input 4 in a transaction request communication to the system). As stated, re-gifting may be made without penalty to the requester/sender, but it is anticipated by the inventor, that in some conceivable embodiments, a small transactional fee may be deducted from a user's system account credit balance upon conducting a re-gift request. Such a transactional fee might encourage users to use redemptions themselves and/or enter the establishments associated with received redemption information 64, thereby possibly improving incremental sales for the establishments honoring the redemption information 64 in exchange for actual items, products, goods, or services. In some embodiments, a portion of the transactional fee, or the entire transactional fee may be provided to the establishment and/or to the system, without limitation.

As may be appreciated from FIG. 595, users may, in some non-limiting embodiments, provide instructions to the system to cash or trade redemption information into another form of payment data 10, without limitation. For example, commands such as “cash”, “trade” and/or the like, accompanied by one or more pieces of redemption information 64, may be provided to the system via an electronic message. Similar functions may be alternatively performed using an optional mobile application 147 or via the system website, without limitation.

According to some embodiments, various features and/or concepts of the inventive technology may be practiced on the go, and this may be appreciated from the appended figures.

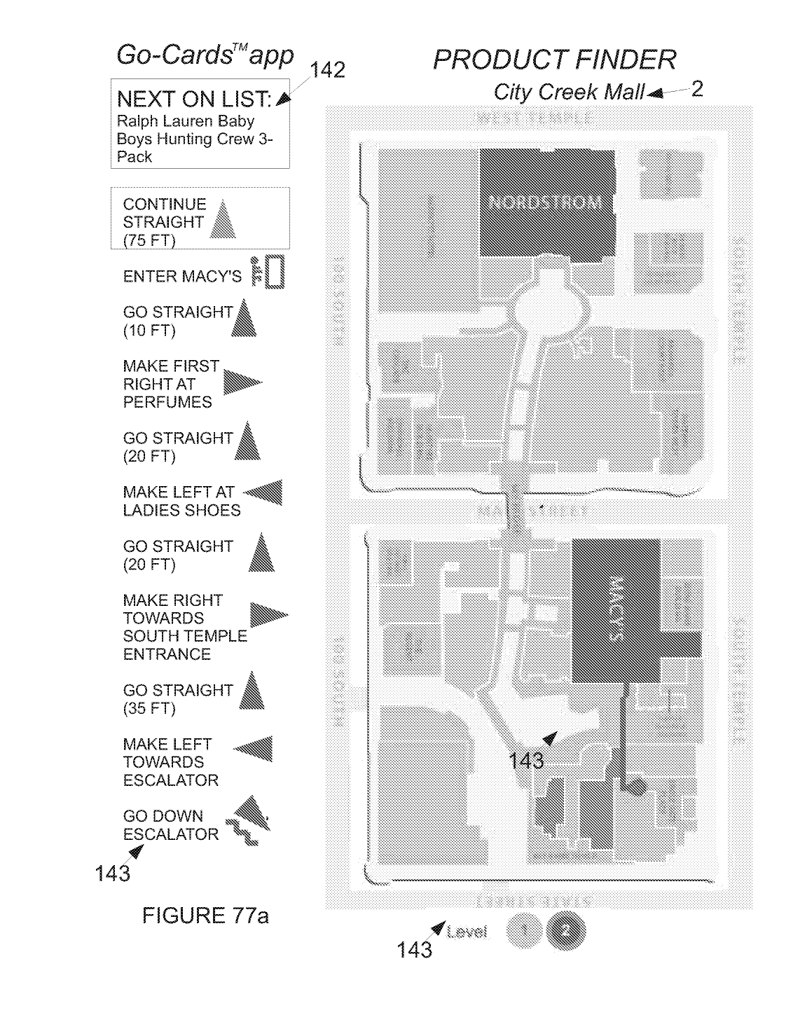

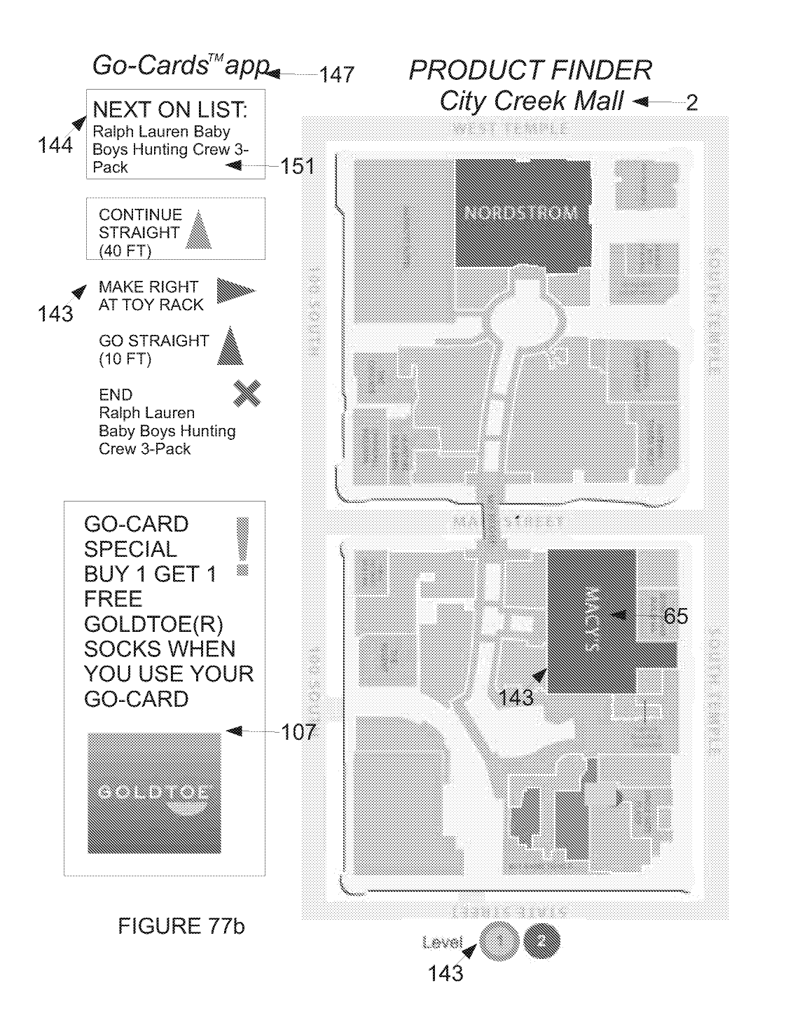

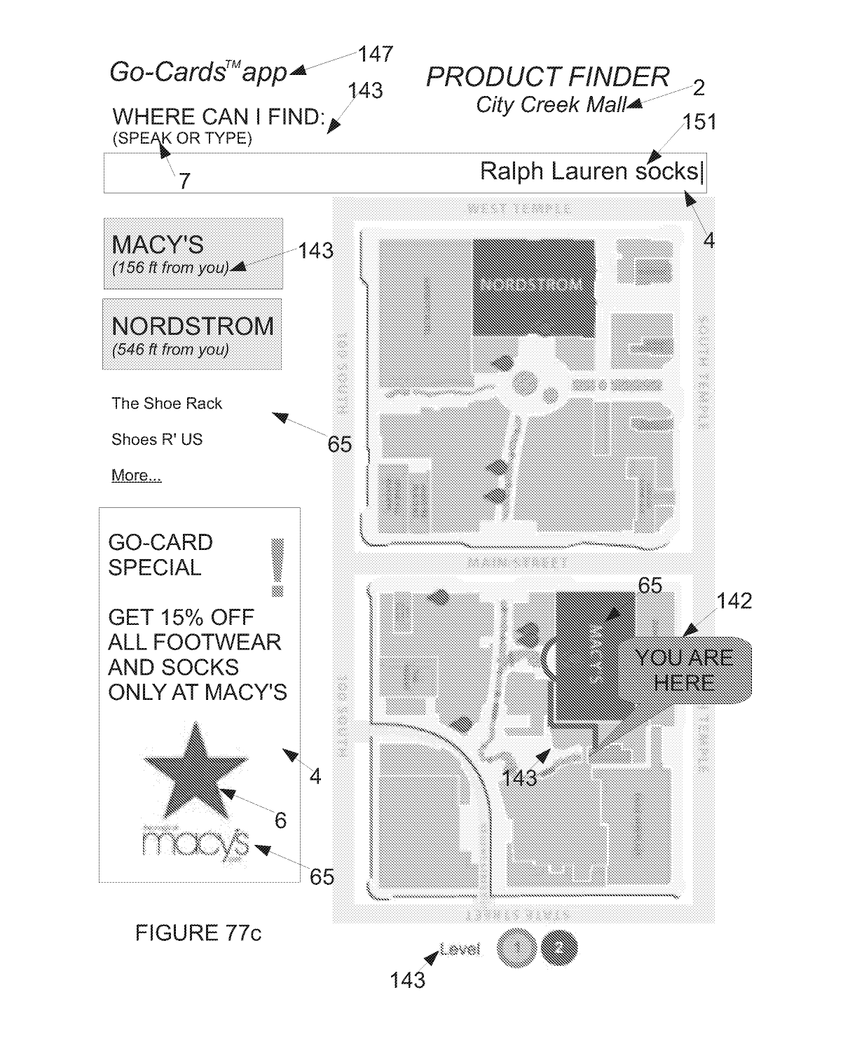

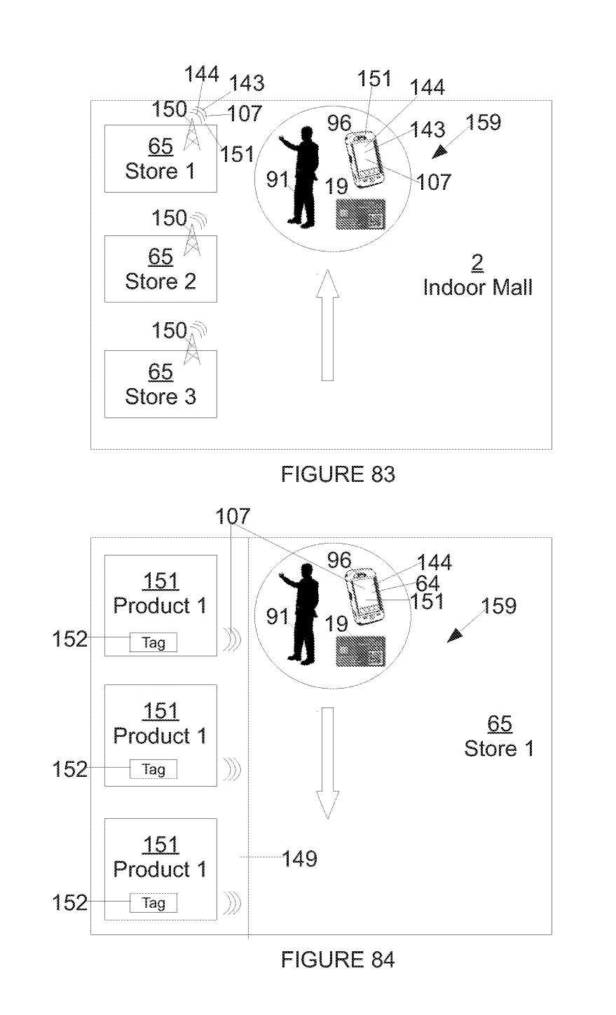

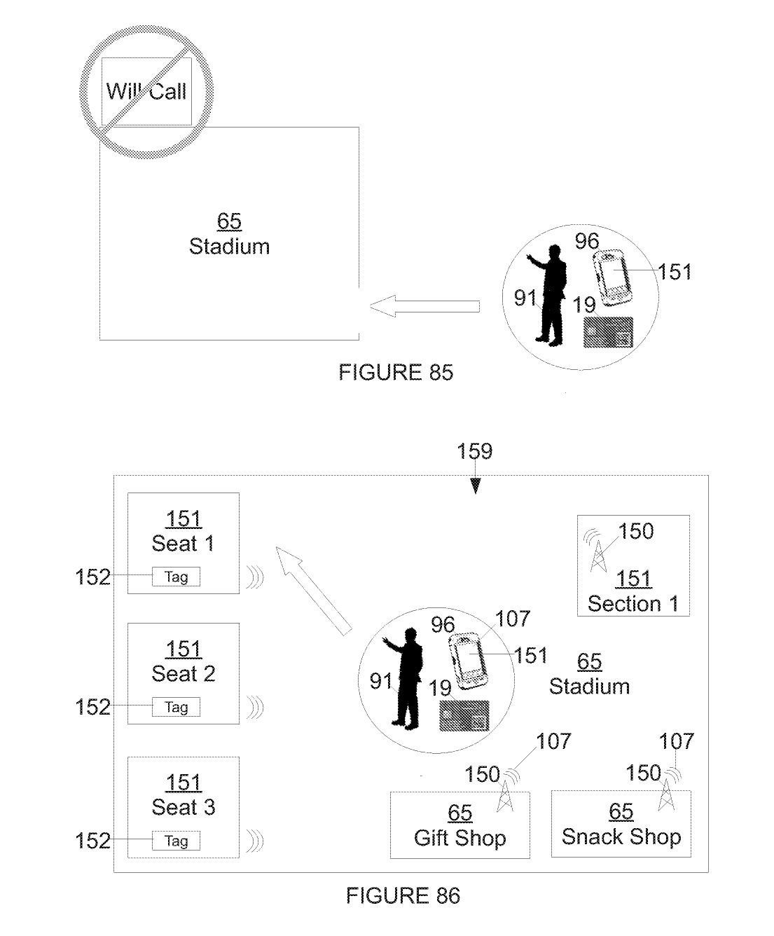

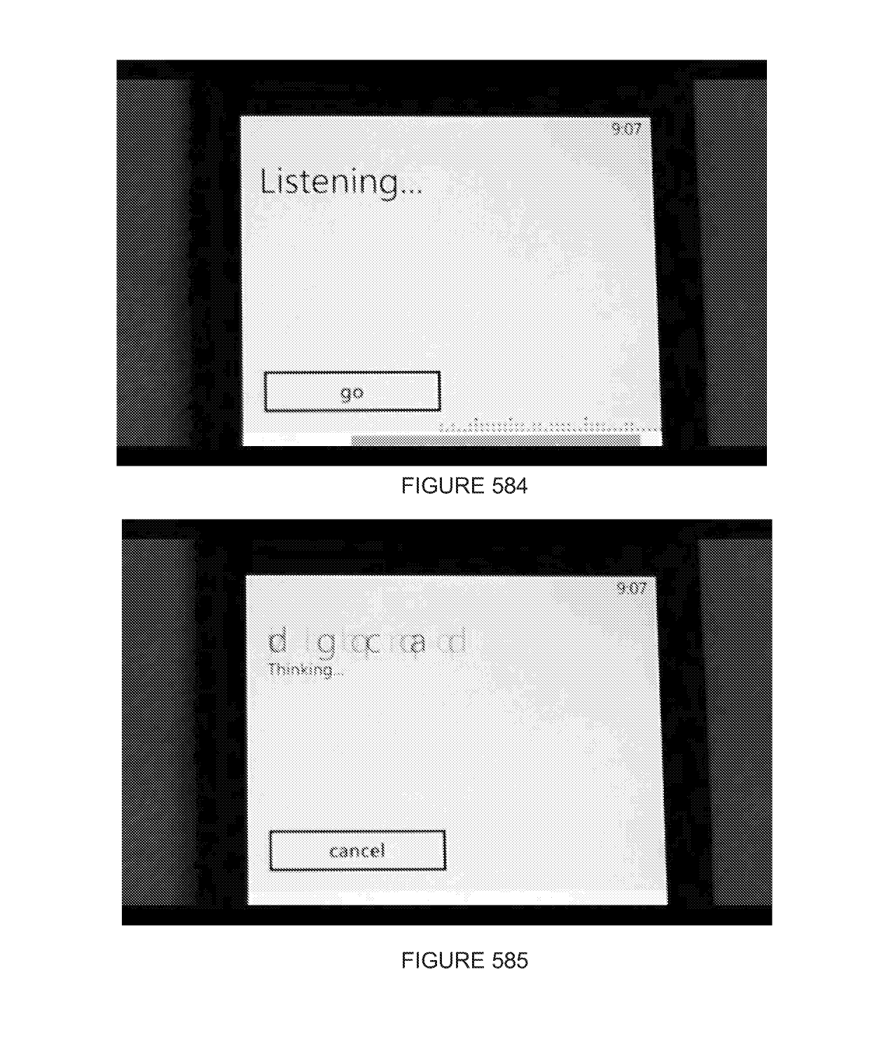

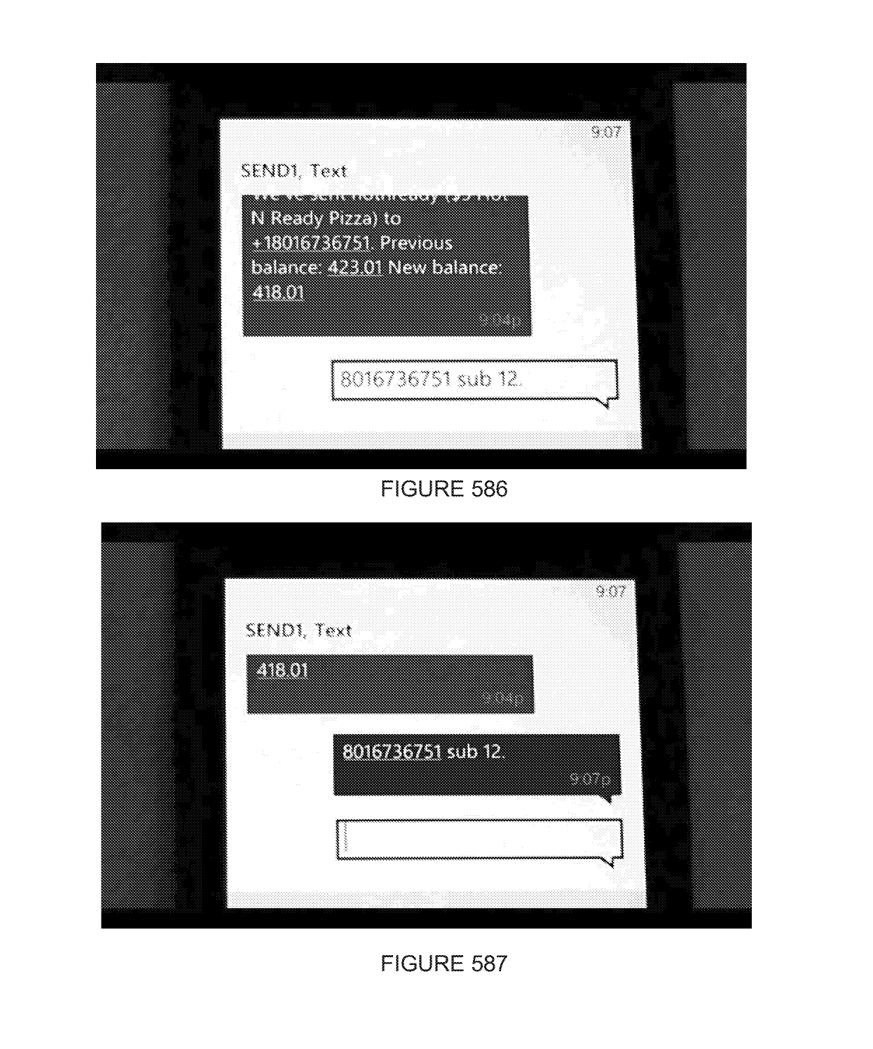

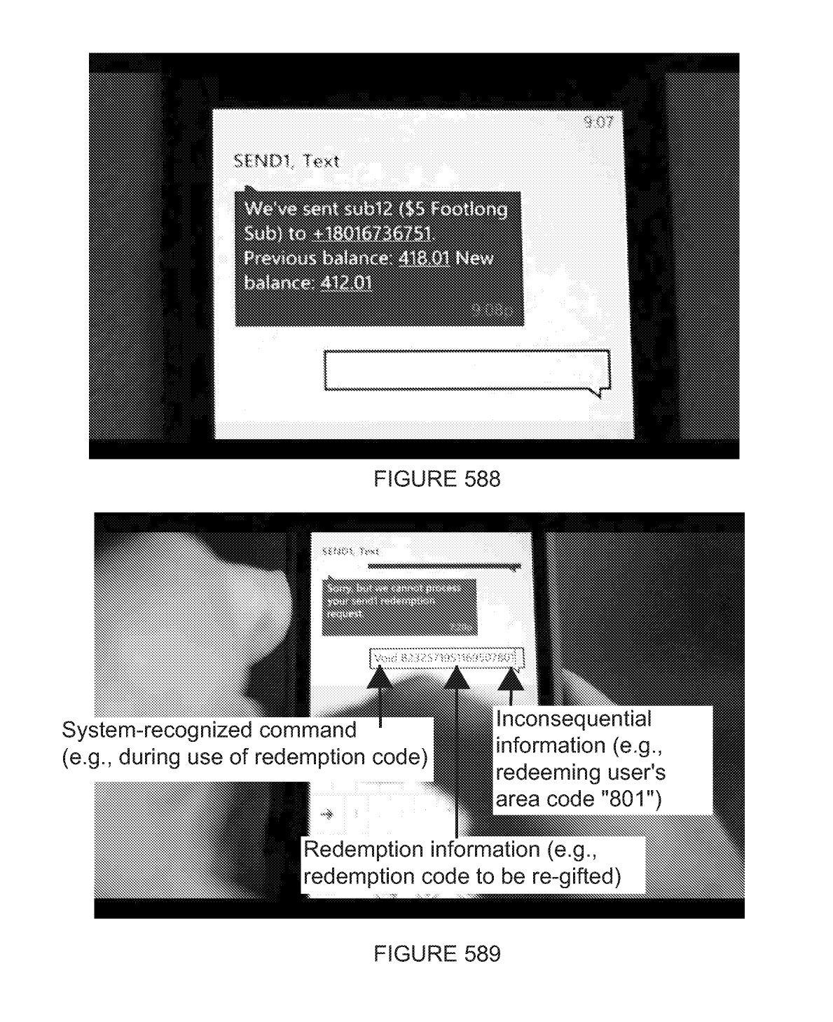

As of the time of this disclosure, many or most phone devices and/or mobile devices 96 in general, may be equipped with voice text, voice dial, and/or voice email capabilities, e.g., through voice command, speech recognition, voice-to-text software, and/or the like, which may or may not be pre-installed or downloaded. As shown, a user may speak or otherwise vocally provide their system transaction request instructions to their mobile device 96 (e.g., cell phone or tablet) and press the send/call button, or simply say “send” or “send message”, depending on the particular software. If a user's mobile device 96 (e.g., smart phone, without limitation) is integrated with a vehicle, via, for example, Bluetooth, or other hands-free technology known in the art, the same method steps may be performed through a vehicle system. Pre-installed communications platforms which may be found in connected cars may be utilized in the performance of functional components of the system, during interactions between system components, and/or during interactions between system components and system users, without limitation. For example, according to some embodiments, a user may provide one or more verbal commands to a system component. According to some embodiments, the step of providing one or more verbal commands may comprise, without limitation, saying or speaking one or more recipient mobile numbers, email addresses, and/or social media addresses (or otherwise saying or speaking a name associated with the one or more recipient mobile numbers, email addresses, and/or social media addresses which is recognizable from an imported “contacts list” stored in a system component) and one or more item codes and/or an amount funds or credits to purchase and send to the one or more recipient mobile numbers, email addresses, and/or social media addresses. According to some embodiments, ordering functions, delivery/delivering functions, trading/cashing functions, liking functions, re-gifting functions, functions involving adding things to a registry, wish list, gift list, or shopping list, functions involving providing a recommendation, functions involving inspecting another user's registry information (e.g., a “peek” function or the like), functions involving sending more information (e.g., web link, event detail, product detail, cost detail, etc.) for later review, performing a social media function (e.g., posting to a wall, sending a direct message), and/or the like, may similarly be performed using one or more system mobile application components, one or more system-integrated mobile application components, and/or one or more suitable mobile device 96 components, without limitation. According to some embodiments, the step of providing a verbal command may comprise the act of saying, speaking, audibly annunciating, audibly articulating, audibly clarifying, audibly navigating (e.g., a menu), verbally instructing, commanding via speech, and/or the like. In some embodiments, the step of providing a verbal command may comprise: speaking one or more recipient names as an instruction to “send to”, speaking one or more names stored in a user's mobile contacts list on a user's mobile device as an instruction to “send to”, and/or speaking one or more recipient electronic addresses as an instruction to “send to”, without limitation. According to some embodiments, a recipient of redemption information 64 may execute the step of providing a verbal command. According to some embodiments, the only recipient of redemption information 64 may be the user executing the step of providing a verbal command (e.g., to purchase, order, or deliver an item, product, good, service, or redemption information relating to an item, product, good, or service for themselves, and/or to perform one of the functions described herein, without limitation). If such is the case, a user may provide his/her own electronic address (e.g., mobile number, email address, social media handle, and/or the like) in an electronic communication to a system component (e.g., system electronic address) using a system component (e.g., a mobile device 96 or computing device 95, etc.). According to some embodiments, the user executing the step of providing a verbal command may be part of multiple recipients receiving redemption information 64, after performing a system transaction request communication with the system which comprises multiple recipient information (e.g., multiple names, contact information, electronic addresses, user card 19 information, etc.), without limitation. According to some embodiments, the user executing the step of providing a verbal command may not be part of recipient information provided in an electronic request communication, without limitation. In some embodiments, a user may purchase an item, product, good, or service for themselves, and receive redemption information 64 for the respective item, product, good, or service, for example, by sending an item code pertaining to the respective an item, product, good, or service and no recipient phone number (e.g., “2movierrentals”, to a system electronic address, without limitation). In some embodiments, a user may purchase an item, product, good, or service for themselves, and receive redemption information 64 for the respective item, product, good, or service, for example, by sending one or more commands, such as the word “buy” or equivalent, along with an item code to be purchased, without limitation. According to some non-limiting embodiments, the item code may be purchased using system-based credit or other form of payment data 10 disclosed herein, including mobile billing or third-party account funds or credits (e.g., linked payment service account (e.g., PayPal), or linked financial institution 163 account), without limitation. According to some embodiments, for platform simplicity and homogeneity, as well as in the best interest of maintaining convention, it may preferred that a sender/requester simply provide their own electronic address in lieu of another person's electronic address in a command, instruction, or transaction request using the system platform, if the sender/requester wishes to purchase one or more items, products, goods, or services and send respective redemption information 64 pertaining thereto, to themselves, without limitation. As previously stated, third-party software and/or hardware such as Apple's Siri or NissanConnect, may be integrated with system software 147 and/or system platform components using system integration software and APIs. In this regard, users may say commands and purchase, gift, send, deliver, recommend, like, wish, add to a shopping list, sign up for events, order, and/or deliver items, products, goods, or services which may be displayed on paper or electronic billboards, signs, displays, truck trailers, vehicle wraps, bumper stickers, balloons, and/or other means for displaying and/or advertising, such as radio-based advertisements, mobile application-based advertisements (e.g., mobile streaming advertisements such as ones provided to applications/websites like Pandora.com, Netflix, Hulu, My Heart Radio, XM radio) and/or the like (e.g., movie trailers being played on a vehicle entertainment system), without limitation. In some embodiments, unused system redemptions (e.g., unused redemption information 64) may be stored in memory or on a hard drive of a component, may be accessed by one or more system components (e.g., a third party application 147 having a user interface 106 (e.g., a browser 131)), and/or may be accessed via system-integrated database 129, 135, 137, 138, 93 with components comprising access means 101, 112 for easy navigation and/or use, including subsequent use, without limitation. For example, in some embodiments, location based services (e.g., cellular triangulation, GPS positioning data, and/or other means for determining a user's location may be utilized in conjunction with a network of billboards, signs, balloons, or displays having known locations), without limitation. Location-based services may be appreciated from at least FIGS. 77a-79, 83-88, and/or FIG. 183, without limitation. For example, as suggested in FIGS. 179a-183, and 584-588, in some non-limiting embodiments, users may provide verbal commands to system components while within in a certain proximity to an outdoor advertisement, for example, while driving on the road, while traveling by train or underground, while on a bus/metro transit, etc., without limitation. Utilizing a system user's instantaneous geographic location (e.g., a geographic position of a component 19, 95, 96, 147 of the system), a user interface 106 component (e.g., a system mobile application, third party mobile application (e.g., vehicle smart dashboard or console system), and/or system mobile device 96 (e.g., a cell phone's text messaging interface 196), without limitation) may receive verbal audio commands from a user driver or passenger user of a vehicle (e.g., a vehicle that belongs to a driver user), and the respective user driver and/or passenger user may perform various transactions and/or interactions with system components (e.g., to buy, gift, like, recommend, add to a wish list, request more info, and/or one or more other functions regarding one or more items, products, goods, or services that are being advertised on a network of billboards, signs, balloons, or displays), without limitation. For example, a first item code may be displayed on a first billboard having a first known location, and a second item code may be displayed on a second billboard having a second known location, wherein the second known location may be positioned a first distance from the first billboard, and, a third item code may be displayed on a third billboard having a third known location which may be positioned at a second distance from the second billboard and/or which may be positioned at a third distance from the first billboard, without limitation. In some non-limiting embodiments, for example, a method of conducting electronic commerce, social functions, and/or other conceivable tasks may comprise, without limitation, a system user 91 driving past at least one of the first, second, or third billboards; a system user 91 reviewing one or more instructions provided on the at least one of the first, second, or third billboards; and/or providing one or more verbal commands to one or more system components (e.g., via a connected car system, hands-free mechanism, intelligent assistant, phone, or other mobile device such as a tablet, without limitation), in order to purchase, order, gift, like, add to a wish list, and/or deliver (e.g., electronically, via electronically-deliverable redemption information 64, or physically, via physical delivery by a human or automated machine (e.g. drone, droid, robot)) a respective one or more items, products, goods, or services displayed on the respective at least one first, second, and/or third billboards being driven past, the respective one or more items, products, goods, or services which may be associated with one or more of the respective first, second, or third item codes provided to the one or more system components, without limitation. Passengers may similarly purchase, gift, like, add to a wish/gift/shopping list, send, donate, etc. items, products, goods, or services, for example, by texting, emailing, or “Tweeting” the first, second, and/or third item codes to a universal system address (or to a respective electronic address provided with instructions on the first, second, or third billboards as shown), along with intended recipient information (e.g., one or more electronic addresses, such as one or more recipient mobile numbers, email addresses, and/or Twitter handles), in the same text, email, or “Tweet” communication, or in a subsequent text, email, or “Tweet” communication, without limitation. In some embodiments, as previously described for box-top television sets/systems, a system-specific button (e.g., a “send1” or “OK” button, without limitation) may be provided to: a steering wheel, a connected car user interface 106, a navigational/GPS unit user interface 106, a mobile device (e.g., running a system mobile application supporting a user interface 106 or browser 106), a remote controller, one or more devices which may be configured to interface/interact/communicate with vehicle software and/or hardware (e.g., hardware configured with audio input means 103), and/or to one or more devices configured to communicate with and/or send instruction-based transaction request communications to components of the system (e.g., server-side software 147, system-integrated databases 129, 135, 137, 138), without limitation. When passing one of the first, second, or third billboards, the system-specific button may be operatively engaged to perform a function associated with the one of the first, second, or third billboards. For example, when within a zone of proximity of a first billboard, operational engagement the system-specific button may perform a first function associated with instructions provided to the first billboard, without limitation. For example, when within a zone of proximity of a second billboard, operational engagement the system-specific button may perform a second function associated with instructions provided to the second billboard, without limitation. For example, when within a zone of proximity of a third billboard, operational engagement the system-specific button may perform a third function associated with instructions provided to the second billboard, without limitation. In some embodiments, the first, second, and/or third functions may be similar or different in nature (e.g., in a hypothetical non-limiting scenario, a first function may comprise purchasing a first item, a second function may be liking a service, and a third function may comprise registering for and/or paying for an event, without limitation).

According to some embodiments, system software 147 provided to various components within the system, may utilize relative positioning information, for example positioning information relating to a user's current location. Positioning information may be determined, for example via a device component 19, 96, 95 of the user and/or various sub-components 147 thereof (e.g., a triangulated signal), in order to determine the distance from, or a position with respect to, at least one of the first, second, or third billboards, without limitation. For example, a current position of a user component 96 relative to a first billboard may be determined, without limitation. For example, a current position of a user component 96 relative to a second billboard may be determined, without limitation. For example, a current position of a user component 96 relative to a third billboard may be determined, without limitation. In some embodiments, the system software 147 may utilize an algorithm to associate verbal commands provided to one or more system components (e.g., one or more voice initiated audible commands (e.g., audio data 7)), tactile input 4 (e.g., physical selection of buttons, indicia, icons as an one or more instructions or commands) provided to one or more system components, and/or other commands or inputs 4 provided by a user to one or more system components, with one of the first, second, or third billboards, depending on the user's distance from (or a relative user position with respect to) the one of the first, second, or third billboards, respectively. In such embodiments, it may not entirely be necessary to provide an item code at all. For example, a user 91 may simply follow instructions provided on a respective billboard (e.g., a user 91 may say “buy” when passing a billboard (or other sign, media, printed matter, or display), without limitation, and so long as the user 91 is within a range, distance threshold, and/or predetermined zone of proximity of the billboard, one or more system components (e.g. system software 147 and/or mobile device 96) may interpret the command (e.g., “buy” instruction), as a transaction request to the system, one or more system components 96 may communicate with one or more other system components (e.g., system servers 128 and/or system-integrated databases 129, 135, 137, 138), one or more system components 96 may send an electronic request communication to one or more other system components 128, 129, one or more system components 128, 129, 147 may be utilized to complete the transaction (e.g., for the item displayed on the respective billboard), one or more system components 128, 129, 147 may be used to access user profile 130 information (e.g., deduct/credit/manipulate the user's 91 system account 48 balance), and/or one or more system components 118, 128, 129, 147 may be utilized to send redemption information 64 pertaining to the “buy” transaction, such as one or more redemption codes (which may comprise one or more scannable/machine-readable images), to the user 91, which may be used by the user 91 immediately, and/or later, without limitation. In some embodiments, to avoid accidental purchasing by a user, for example, during a conversation containing the word “buy”, a specific activation command or unique verbal instruction may precede another verbal instruction to one or more system components (e.g., “send1 . . . buy . . . ”), without limitation. In some embodiments, redemption information 64 received by the user 91 may be delivered to another user, for example, upon receipt of the redemption information 64, or after receipt (e.g., via a re-gift function request to the system). In some embodiments, the redemption information 64 (e.g., redemption information 64 associated with the “buy” transaction request) may be delivered to one or more system components 96, 95 of the user (e.g., using one or more electronic and/or physical addresses contained within the user's 91 system profile 130). In some non-limiting embodiments, redemption information 64 may be delivered to the user 91 via one or more of the following platforms: mobile application, SMS-messaging protocol, MMS-messaging protocol, email, a phone call (e.g., person-generated or automated), a web-based platform (e.g., to an inbox or “redemptions list” associated with a system website 127, website portal, and/or accessible secure profile 130 page(s)), physical delivery (e.g., parcel post, human-facilitated delivery, robot or automated device delivery, drone delivery, etc.), and/or via a social media platform, without limitation.

According to some non-limiting embodiments, a user may provide other verbal commands associated with various system functions described herein. For example, a user may provide a verbal command such as, saying/speaking the word “send1” or “gift” or “send” (or the like), and may accompany the verbal command (e.g., prior to or after the verbal command), for example, with recipient information (e.g., a provided one or more electronic addresses associated with respective one or more recipients). The recipient information may comprise, without limitation, information, such as an intended recipient's mobile number, an intended recipient's email, an intended recipient's screen name, an intended recipient's profile ID number, an intended recipient's physical address, an intended recipient's social media account identifier (e.g., Twitter handle), one or more system “vanity” electronic addresses, and/or the like, without limitation.

In some embodiments, so long as: a) the user's physical geographic location lies within a predetermined range of a first billboard; b) received inputs 4 (e.g., verbal command instructions) are deemed to be interpretable and/or confirmed by one or more subsequent user verbal confirmation inputs 4; and/or c) user profile information 130 (e.g., information pertaining to a system account balance associated with the user's profile 130/electronic address(es)) is deemed sufficient to perform the transaction associated with a first billboard (e.g., using a system-integrated application 147), one or more system components may execute/perform the transaction associated with the first billboard. In some embodiments, executing/performing the transaction associated with the first billboard may involve physically and/or electronically gifting an item, product, good, or service displayed on the first billboard, without limitation. In some embodiments, executing/performing the transaction may involve deducting an account 48 balance of the user 91 or otherwise manipulating profile 130 information of the user 91, for example, an account 48 balance of the user 91 may be deducted by: an amount consistent with the number of provided/indicated recipients, an amount consistent with system terms and conditions (e.g., transaction fees, taxes, delivery fees, etc.), and/or an amount consistent with instructions/item code(s) provided to the first billboard, without limitation. In some embodiments, executing/performing the transaction may involve electronically sending one or more requesting user-indicated recipients: redemption information 64 (e.g., in the form of one or more redemption codes, PINs, scannable images, and/or instructions) pertaining to a transaction, for example, a transaction regarding a first billboard, without limitation. In some embodiments, the step of electronically sending redemption information 64 may comprise delivery of redemption information 64 to a recipient via at least one of the following platforms: mobile application, SMS, MMS, email, phone call (person or automated), and/or social media platform), without limitation. In some embodiments, the step of electronically sending redemption information 64 may comprise delivery of redemption information 64 to multiple recipients, which may or may not include the requesting user, without limitation. In some embodiments, executing/performing the transaction may involve physically sending a requesting user-indicated recipient: one or more actual items, products, goods, and/or services which may pertain to a transaction, such as a transaction associated with a first billboard (e.g., item code, cost information, and/or instructions provided to the first billboard), without limitation. In some embodiments, physically sending may involve physically sending one or more actual items, products, goods, and/or services to multiple recipients (including or not including the requesting user), without limitation. In some embodiments, physically sending may comprise, for example, using requesting user-provided recipient physical address information provided by the requesting user during a transaction request, without limitation. In some embodiments, physically sending may comprise, for example, extracting physical address information and/or current location information of one or more requesting user-provided recipients, for example, based upon one or more requesting-user provided recipient electronic addresses, without limitation. In some embodiments, physically sending may comprise, for example, determining (e.g., using available online data resources or profile 130 information stored in one or more system-integrated databases 129, 135, 137, 138) recipient physical address information, for example, based upon one or more recipient electronic addresses provided by a requesting user 91 during a transaction request, without limitation. In some embodiments, redemption information 64 may be electronically delivered by system components to a particular recipient via one of the following platforms: mobile application, SMS, MMS, email, phone call (person or automated), and/or social media platform, without limitation. Other platforms (e.g., television-based platforms, connected car platforms, browsers, and/or the like) may be used to receive electronic communications from system components 128. Moreover, in some embodiments, other platforms (e.g., television-based platforms, connected car platforms, browsers, and/or the like) may be advantageously employed and/or utilized to display and/or audibly emit redemption information 64 to a user (e.g., via a suitable user interface 106), without limitation. The aforementioned integrations, system components, and inventive methods and concepts may, in some embodiments, be employed, practiced, and/or utilized to perform a variety of tasks as one or more system outputs 5. For example, the inventive technology may have applicability with signing up for and/or paying for events (e.g., 5 k race events), without limitation. For example, the inventive technology may have applicability with donating funds and/or items, products, goods, or services to charities (e.g., donating “5.00” to St Jude's Research Hospital, or donating a dozen canned goods to a local Boy Scouts of America Thanksgiving food drive), without limitation. For example, the inventive technology may have applicability with event registrations and/or enabling a user to quickly and conveniently register for events (e.g., golf tournaments, raffles, lotteries), without limitation. For example, the inventive technology may have applicability with buying tickets (e.g., for a show, concert, play, movie, or venue (e.g., ski resort lift ticket)), without limitation. For example, the inventive technology may have applicability with buying and/or gifting (whether physically delivered or delivered in an electronic equivalent format) one or more items, products, goods, or services, etc. The inventive technology may, in some embodiments, make shopping in the store or driving down the road like surfing an online merchant's 65 website or browsing an online store. The inventive technology may, in some embodiments, improve the ease and/or simplicity of performing certain transactions known to exist in the public domain. The inventive technology may, in some embodiments, mitigate security issues involved with keeping banking and/or credit card information on file with numerous vendors or otherwise storing banking and/or credit card information on third party 93, 65 servers 125, 136 or databases 135, 137, without limitation. According to some embodiments, the system platform may be utilized for small amount transactions, including, but not limited to online transactions. According to some embodiments, system user privacy and/or creditworthiness may be maintained by frequently re-loading their system account balance with small cash amounts or otherwise amounts which are comfortable to a user to utilize the inventive features and concepts disclosed herein. Re-loading system account 48 balances may be performed at a participating entity 65 location 2, for example, in person at a checkout terminal location, or may be performed online, without limitation. For example, in some embodiments, re-loading accounts may be performed on the system website 127, or on a third-party website such as a financial institution 163 website, wherein a user may, once logged onto the third-party website, transfer funds from one user account 48 into a system account 48 associated with a system profile 130, without limitation. In some embodiments, users 91, 92 may keep as much, or as little funds or credits as they like on a system card 19 or system account balance. In some embodiments, a user may purchase a new system card at a brick-and-mortar store and activate immediately. In some embodiments, a user may swipe, tap, scan, or otherwise read a system card 19, using components of a payment terminal or kiosk 3 which may comprise payment receiving means 100, during a re-loading transaction (e.g., a transaction involving adding funds or credits (including redemption information 64) to a user profile 130, without limitation. Figures contained within U.S. Provisional Patent Application No. 62/040,402, which are not shown in the appended figures, but which are hereby incorporated by reference in their entirety, suggest various non-limiting ways of purchasing credit.

According to some non-limiting embodiments, participating entities 65 (e.g., which may include merchants, selling entities, and/or other users 91, 92 of the system), may use a built-in “void” command (or the like, such as “redeem” or the like), in order to complete transactions regarding the use/redemption of redemption information 64, without limitation. As shown in the figures (in particular, FIG. 589) one or more pieces of inconsequential information (e.g., such as one or more portions of a recipient user's mobile phone number, area code, last four digits of their email, first three characters of their email address, email address client (e.g., “Yahoo”), one or more portions of system-integrated card 19 information, account numbers, card 19 numbers, etc.) may be utilized in combination with redemption information 64 (e.g., a redemption code), according to a predetermined system convention. For example, inconsequential information may be provided before or after a redemption code, as shown in the figures, without limitation. In some embodiments, one or more pieces of inconsequential information may be requested by a redeeming user, for example, in a prompt or query contained in one or more subsequent system-delivered follow-up communications, without limitation. For example, after providing a redemption code in a void transaction request to the system, the system may reply to a redeeming user 65 with a randomized prompt or query asking the redeeming user 95 for specific user data 8 in a manner which is unique to a particular transaction (e.g., wherein prompts or queries for inconsequential information may change or vary between void requests, or wherein inconsequential information may not be provided in void transaction requests according to a predetermined system convention). For example, according to one non-limiting example, a redeeming participating entity user 65 voiding first redemption information 64 on behalf of a first requesting user 91, may make a first transaction request to the system, and the system may respond with first instructions (e.g., a question or prompt to provide area code inconsequential information); wherein a redeeming participating entity user 65 voiding second redemption information 64 on behalf of a second requesting user 92, may make a second transaction request to the system, and the system may respond with second instructions which are not equivalent to the first instructions (e.g., a query or prompt to provide last 5 characters of an email address as inconsequential information). In this regard, fraudulent activity including “guessing” or artificially manufacturing redemption codes may be mitigated or avoided altogether, and/or redemption information may be abbreviated (e.g., with less concern over probable statistical guesswork regarding redemption information), without limitation. In some embodiments, the entire text within the send1 communication may be parsed to identify redemption information (e.g., one or more redemption codes and/or PINs) and segregate it from the “void” command (or the like), and/or segregate it from a piece of inconsequential information (in the embodiment shown in FIG. 589, the inconsequential information comprises the recipient's area code “801”), without limitation. In some embodiments, the system may, in some instances, require one or more pieces of inconsequential information to accompany every void request and/or accompany every reply communication from the system (e.g., containing instructions such as a question or prompt) following a void request. In some embodiments, the system may, in some instances, not require one or more pieces of inconsequential information to accompany every void request and/or accompany every reply communication from the system (e.g., containing instructions such as a question or prompt) following a void request. In some embodiments, random requests for inconsequential information may be made from system components to a redeeming participating entity user 65 voiding redemption information 64 of users 91, 92, so that users 91, 92 wishing to use/redeem redemption information 64 may, on occasion, be prompted to provide inconsequential information, without limitation. In some embodiments, options to require inconsequential information in order to successfully redeem certain redemption information 64, may be selected and stored as participating entity 65 preference 63 in a database 129. In some embodiments, use of inconsequential information may be determined by the system, according to system user agreements and or system rules, procedures, or protocols. Such practice of providing inconsequential information may improve security (e.g., by mimicking a form of 2-stage authentication). In some embodiments, inconsequential information may be provided from a participating entity 65 in a reimbursement claim to a component of the system, without limitation (e.g., a list of voided redemption codes may be provided in a claim to the system, wherein received inconsequential information may be provided adjacent to each redemption code for system validation). In some embodiments, a fraudster may need to know both the inconsequential information and the redemption code to make a fraudulent redemption, and therefore, in some preferred embodiments, if first redemption information 64 is delivered to a first electronic address of a user, requests for inconsequential information in relation to use/redemption of the first redemption information may comprise prompts for inconsequential information which may not comprise information pertaining to the first electronic address, but rather a portion of a card 19 number, image data 6, audio data 7, or second electronic address, without limitation. In some instances, a one-time claim code may be delivered to a user and/or participating entity 65 upon use/redemption of redemption information 64. In some embodiments, the one-time claim code may be delivered to the recipient's mobile device 96 (e.g., phone) and the recipient's mobile device 96 may be provided to the merchant to (e.g., to show, read, scan, the one-time claim code) to complete the transaction. As stated herein, a one-time claim code may be delivered via various electronic communication protocols, and may contain various forms and combinations of forms of image data 6 and/or audio data 7, without limitation. Embodiments employing one-time claim codes, utilizing one-time claim code, and/or practicing method steps associated with one-time claim code functions disclosed herein, may use one-time claim codes as another layer of security, wherein such embodiments, a fraudster may necessarily need to have instant real-time access to a redeeming user's mobile device 96 (e.g., a cellular phone, a mobile computing device 95, a smart watch, a wearable computer, a tablet, an Apple brand iPad/iPod, a gaming device, etc., without limitation), instant real-time access to a redeeming user's computing device 95, and/or instant real-time access to a platform affiliated with a user's electronic address (e.g., instant real-time access to a user's Twitter account, instant real-time access to a webmail account, etc.), without limitation, in order to utilize redemption information 64. According to some embodiments, a system void command (or the like), for example, when used in conjunction with a valid or otherwise unused or partially used redemption code, and when optionally used in conjunction with optional inconsequential information (e.g., area code of the user to which the redemption code belongs) which matches profile 130 information stored in a system-integrated database 129, may trigger delivery of the claim code from one or more system components, to the user trying to redeem the valid or otherwise unused or partially used redemption code in exchange for tangible money, item(s), product(s), good(s), or service(s). According to some embodiments, a participating entity 65 (e.g., a merchant accepting/honoring redemption information 64) may write this claim code information down as “receipt confirmation” of used/redeemed redemption information 64. In some embodiments, receipt confirmation information may be used or stored by participating entity 65 as a record of a use/redemption transaction. In some embodiments, receipt confirmation information may be provided to one or more components of the system (e.g., via mail, file upload, via a system website 127 portal, via payment terminal interface configured with system software 147, and/or the like), for example, on a periodic basis or real-time basis, in order to obtain reimbursement from the system. In some embodiments, a claim code may not be delivered and/or used, wherein a redemption code may simply be accepted, and voided by a participating entity 65, without limitation (such may be the case, for example, in instances wherein the system may have pre-paid the respective participating entity 65 for the system-delivered redemption information 64, wherein the system may have been made whole by the sending user (e.g., upon a sending user purchasing system credit and requesting a purchase transaction using the sending user's system credit), and/or wherein the respective participating entity 65 may not need to be reimbursed, without limitation). In some embodiments, a participating entity 65 may create a record of redemption information 64 when the redemption information 64 is used/redeemed. In some embodiments, upon use/redemption of redemption information 64, system components 118, 129, 147 may instantly credit the electronic address (e.g., a mobile number, social media profile, and/or email address, without limitation) which may be associated with an originating electronic address used to make the void request communication to the system. In some embodiments, upon use/redemption of redemption information 64 system components 118, 129, 147 may be used to instantly credit the participating entity 65 account (e.g., merchant's account), for example, if/when at least one valid redemption code, is entered into a payment terminal configured with system payment software 147 (e.g., integrated API's) which may comprise a suitable user interface 106. It should be understood that at least one: accompanying PIN, one-time pass code, piece of inconsequential information, portion of user data 8, and/or combination thereof, may be provided as an input(s) 4 to a payment terminal configured with system payment software, for example, at the time of presentation of at least one valid redemption code.

According to some embodiments, a user may have items, products, goods, and/or services electronically or physically delivered, without limitation (FIG. 592). For example, a user may have items, products, goods, and/or services delivered with the keyword “order” (or the like, such as “deliver”, or the like). According to some embodiments, the order command/instruction communication to the system may comprise redemption information (such as one or more redemption code and/or optional associated PINs), without limitation. According to some embodiments, the order command/instruction communication to the system may comprise one or more item codes, without limitation. According to some embodiments, the order command/instruction communication to the system may comprise one or more security features, such as one-time pass codes, card 19 information, or the like), without limitation. It is envisaged that other alternatives to the word “order” may be used instead, or in addition, without limitation. For example, alternatives may comprise one or more instructions or commands (including verbal commands) which may be indicative of physically gifting in a predetermined language, for instance, the word “send,” or “deliver,” or the like, without limitation. In the non-limiting shown embodiments, a user may place a keyword before, or after a redemption code in an electronic request communication to the system (e.g., in a text-based message addressed to a system electronic address. In some non-limiting embodiments, so long as the keyword “order” (or equivalent) is used, and an item code and/or a redemption code is provided (e.g., wherein the item code and/or redemption code is representative of one or more items, products, goods, or services which is/are appropriate for delivering through mail or person (e.g., food, tutoring services, computer services, or flower delivery, or the like, without limitation)), the system may deduct the requester's account 48 balance or profile 130 unused redemptions as necessary, and system components (including, but not limited to participating entity 65 and/or third party components), may facilitate delivery of the respective one or more items, products, goods, or services, without limitation. In some instances, if one or more system components 147 cannot recognize an instruction, comprehend an instruction, and/or experiences a logical conflict (e.g., two commands in the same transaction communication), the one or more system components 147 may be configured to do nothing, or the one or more system components 147 may be configured to deliver an error message along the lines of “We're sorry, we cannot complete your request as entered or stated”, without limitation. In some embodiments, a first keyword (e.g., a keyword “send” or the like) may be reserved for ordering things to be delivered to one or more other recipients, and a second keyword (e.g., “order” or the like), may be reserved for sending items to the requester (e.g., for themselves), or vice-versa, without limitation. For example, if a user 91, with physical address information on file with the system (e.g., in a profile 130 of the user 91 on a system database 129), uses the word “order” and a valid redemption code for 2 medium, 2 topping Domino's brand pizzas in a system “order” transaction request, system components may electronically communicate the user's incoming electronic address information (e.g., a phone number), physical address information, relevant payment data 10, relevant purchase data 9, relevant user data 8, relevant redemption data 64 and/or item code data to a Domino's server 136, without limitation. Software 147 provided to the Domino's server 136 may convey the received information into a Domino's database 137 and/or electronically deliver the information to a local Domino's venue/location 2, such as a store location which is most adjacent to the received physical address information, without limitation. Domino's 65 may call the user 91 back (e.g., via a human representative, or via an automated navigable menu phone script configured to receive one or more user inputs 4 and serving as a user interface 106), for example using electronic address information (e.g., a phone number) accessed from the system database 129 or and provided by the system in the electronically communicated data sent to Domino's; wherein the call from Domino's 65 may prompt the user to provide instructions on how to prepare the pizzas, without limitation. In such an instance, Domino's may not ask the user for a form of payment data 10. In some embodiments, Domino's may have access to physical and/or electronic address information on file in a system database 129, which may have been previously provided by the user 91 to send1, through send1's API. The call may be automated, or be made by a human, and sent from one or more system components on behalf of Domino's, or made directly by the local Domino's most adjacent the requesting user's physical address, without limitation. Domino's 65 and/or the system may void the used/redeemed redemption code, Domino's 65 and/or the system may deliver electronic receipt information 20 to the user 91 as an output 5, and Domino's 65 may then send a delivery person to deliver the customized 2 medium, 2 topping pizzas to the physical address of the user 91, without limitation. In some embodiments, electronic receipt information 20 may be conveyed to the user 91 during the phone call from Domino's 65 to the user 91, without limitation. In some embodiments, electronic receipt information 20 may be conveyed to the user 91 in a separate SMS or MMS message associated with the number used to make the phone call from Domino's 65 to the user 91, without limitation. In some embodiments, rather than a call from Domino's 65 to the user 91, software 147 associated with a Domino's server 136, integrating a system server 128 and a Domino's server 136, and/or system software 147, may send one or more electronic message communications to the user 91, the one or more electronic message communications to the user 91 requesting further information from the user 91, as necessary to complete the order request, in a series of prompts to the user 91. The one or more electronic message communications to the user 91 may comprise, for instance, any combination of: one or more text messages, one or more SMS messages, one or more social communications, one or more emails, and/or one or more web-based mobile application 147 user interface 106 communications, without limitation. It should be appreciated that similar platforms may be advantageously utilized to provide the user 91 with an electronic receipt, as a system output 5, without limitation.

In some embodiments, instructions may be provided within an order request transaction communication made to the system, without limitation. For example, an order request transaction communication from a requesting user 91 to a system electronic address may comprise, without limitation: a) an “order” command (or the like), b) valid redemption information 64 (e.g., an unused redemption code such as “8139283749242041”) and/or a system-recognized item code (such as “Dominos22”), and c) one or more instructions regarding user preferences 63 relating to the order (e.g., “One pepperoni and one Hawaiian style”, without limitation. In some embodiments, the one or more instructions may be placed at the end of the order request transaction communication, without limitation. Components of the system may: receive the order request transaction communication; may determine the electronic address originating the order request transaction communication; may access a profile 130 in a system database 129 associated with the electronic address originating the order request transaction communication; may determine whether or not redemption information (e.g., a redemption code) is provided within the order request transaction communication; may determine (if provided) whether or not redemption information (e.g., redemption code) is associated with the profile 130; may determine whether or not a system-recognized item code is provided within the order request transaction communication; may process information from the order request transaction communication; may parse the contents of the order request transaction communication as necessary; may store the information (e.g., as metadata 90) into the user's respective profile 130; may void valid redemption information 64 within the user's respective profile 130 which matches redemption information 64 contained within the order request transaction communication; may credit an account 48 balance of the participating entity 65 associated with the respective voided redemption information 64 (e.g., a system account balance of Domino's within a profile 130 of Domino's in a system database 129) by an amount representative of (or by an amount less than (e.g., as a system fee)) a system “cost” value of the voided redemption information 64; and may provide information (e.g., information contained within the order request transaction communication and information regarding confirmed funds transfer) to the respective participating entity 65 in a digital electronic data communication (e.g., to a Domino's electronic address in an electronic message communication, and/or to a Domino's server 136 or database 137, via a web-based POST submission, without limitation). Dominos may receive the information from one or more system components and perform the rest of the delivery transaction (e.g., fulfill the order, and make the delivery of the requested items, products, goods, and/or services—in the provided non-limiting scenario: two pizzas, without limitation).

In some embodiments, components of the system (particularly software 147 components) may be configured such that a user 91 may add additional items in an order request, without limitation. In such embodiments, components of the system (particularly software 147 components) may be configured to debit an account 48 associated with the user's 91 system profile 130, for example, as a form of payment for the additional items provided in the order request. For example, continuing from the abovementioned exemplary embodiment, if a hypothetical order transaction request communication to the system comprises instructions from a user 91 such as “One pepperoni and one Hawaiian style, add 2 L Coke and a side of 6-pc Buffalo hot wings”, the additional items (e.g., “2 L Coke and a side of 6-pc Buffalo hot wings”) may not be covered by the provided redemption information 64. In this regard, Domino's 65 may, upon receipt of such system-delivered information, send an invoicing electronic communication back to a system server 128 with an “amount due” for the difference (e.g., the cost of “2 L Coke and a side of 6-pc Buffalo hot wings”, plus any necessary fees or taxes), without limitation. System components 128, 129, 147 may, upon receipt of the invoicing electronic communication from Domino's 65, verify whether there are sufficient user 91 funds for the “amount due” in an account 48 of the user's 91 profile 130; may debit the user's 91 account 48 by an amount equivalent to (or by an amount greater than (e.g., as a system service fee)) the “amount due”; may credit an account 48 balance of the participating entity 65 associated with the respective invoicing electronic communication (e.g., a Domino's account 48 balance) by an amount equivalent to (or by an amount less than (e.g., as a system service fee)) the “amount due”; and may electronically deliver a confirmation of payment communication with receipt 20 information back to the participating entity 65 (e.g., Domino's) associated with the respective invoicing electronic communication system, as an output 5, without limitation. In some embodiments, system software 147 may provide an electronic receipt 20 regarding the order transaction request communication, wherein the receipt 20 may comprise an itemized list of items/products/goods/services provided, redemption information 64 utilized, and/or funds/credits debited during the order transaction, without limitation. Various forms of ordering using the inventive technology are contemplated, and though not every conceivable permutation of system component interactions can be concisely described herein, such conceivable permutations of system component interactions are anticipated, without limitation.

In another non-limiting example, a user 91 may send a bouquet of flowers to another user 92 for example, by providing the word “send” and, either a valid redemption code for the bouquet, or an item code (e.g., “FTDbouquetsmall”), without limitation. In some embodiments, system components may reply to the electronic address originating the send request, with one or more reply communications. For example, reply communications may be sent in one or more emails if the send request was made via email, without limitation. For example, reply communications may be sent in one or more text messages if the send request was made via a text message, without limitation. For example, reply communications may be sent in one or more social posts if the send request was made via a social post, without limitation. For example, reply communications may be sent in one or more phone calls, if the send request was made via a phone call, without limitation. In some embodiments, if a phone call is used to make a send request, reply communications may be made within the same phone call, without limitation. For example, reply communications may be sent via a mobile application 147 user interface 106, if the send request was made via one or more mobile application interactions, without limitation. The one or more reply communications may contain prompts or instructions asking for the recipient's physical address, and the user may follow the prompts or instructions, accordingly, as necessary to complete the transaction and facilitate delivery of the respective goods/services (e.g., delivery of a bouquet of flowers to the other user 92). In some embodiments, system components may, e.g., on behalf of a requesting user 91, contact a recipient 92 (e.g., using a provided electronic address contained within the send request), and may ask them for their physical address/delivery/shipping information in one or more communications to the recipient 92, without limitation. In this regard, the requesting user 91 wishing to send the bouquet need not be troubled with providing recipient 92 information in order to request and/or pay for the transaction. Moreover, in this regard, the system and the requesting user 91 may be confident that the recipient's 92 physical address information is accurate and/or up-to-date. The one or more communications to the recipient 92 may contain prompts or instructions asking for the recipient's physical address, and the recipient 92 may follow the prompts or instructions, accordingly, as necessary to complete the transaction and facilitate delivery of the respective goods/services to the recipient.

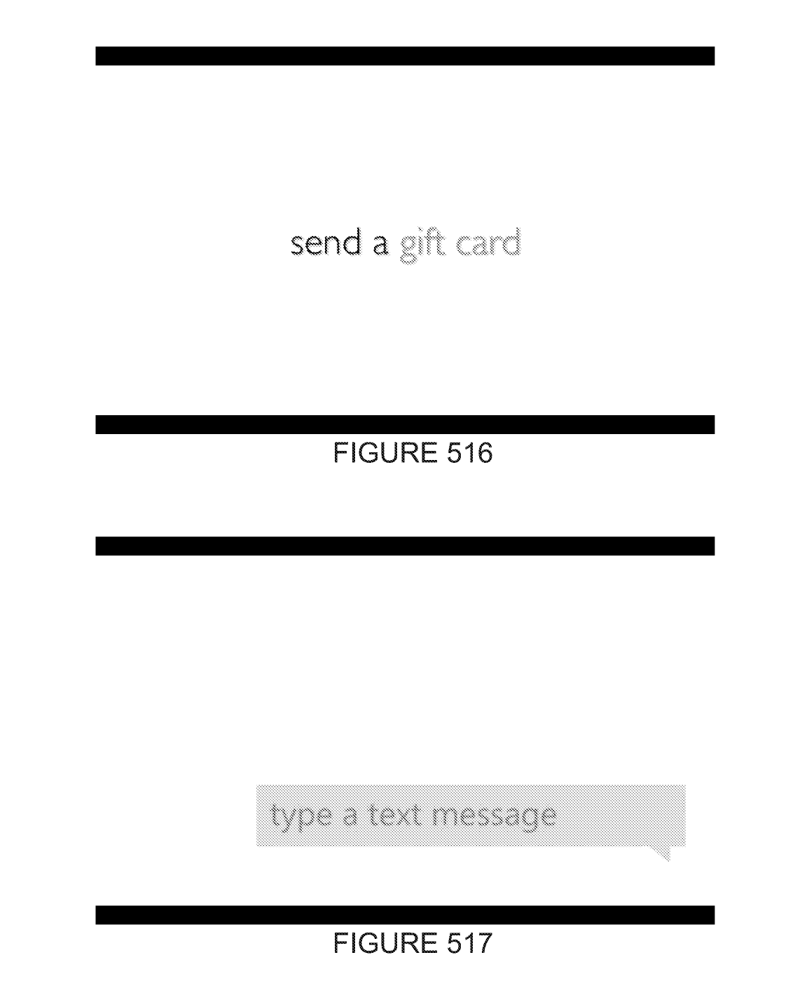

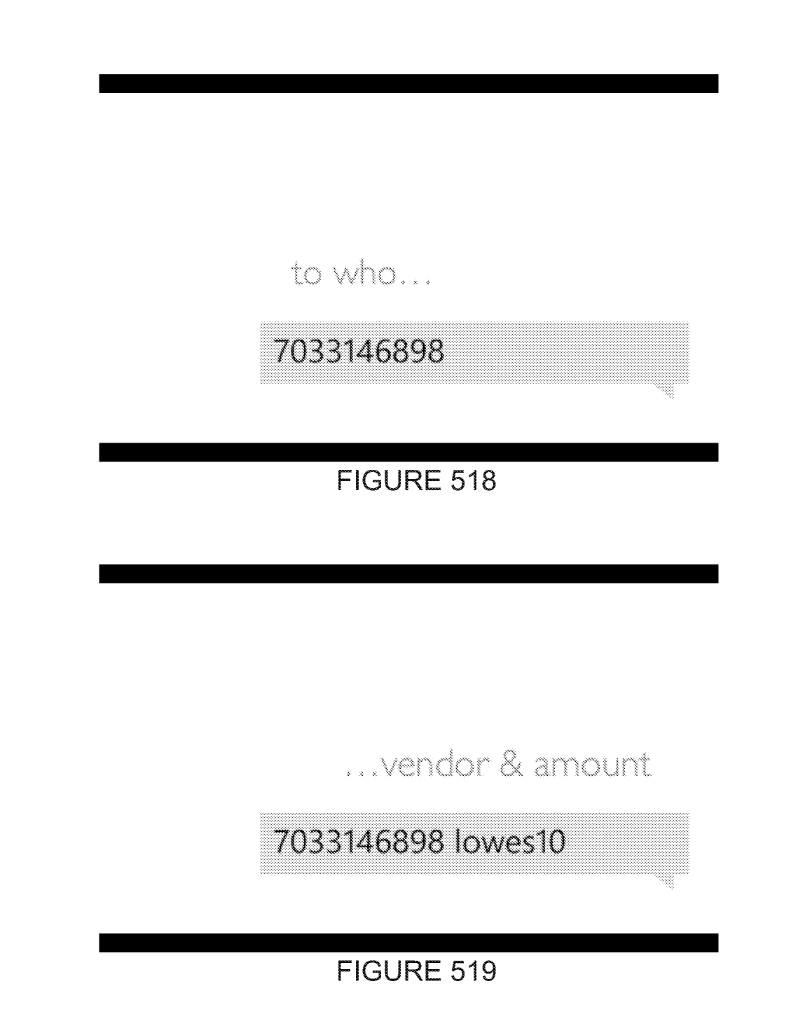

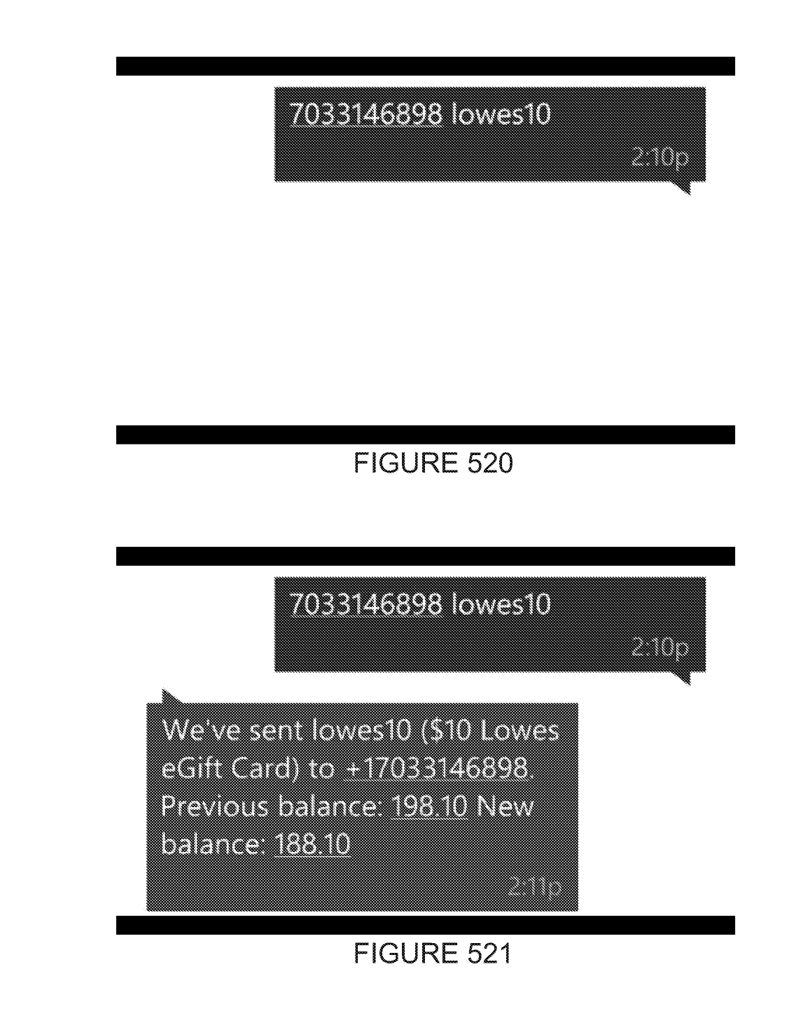

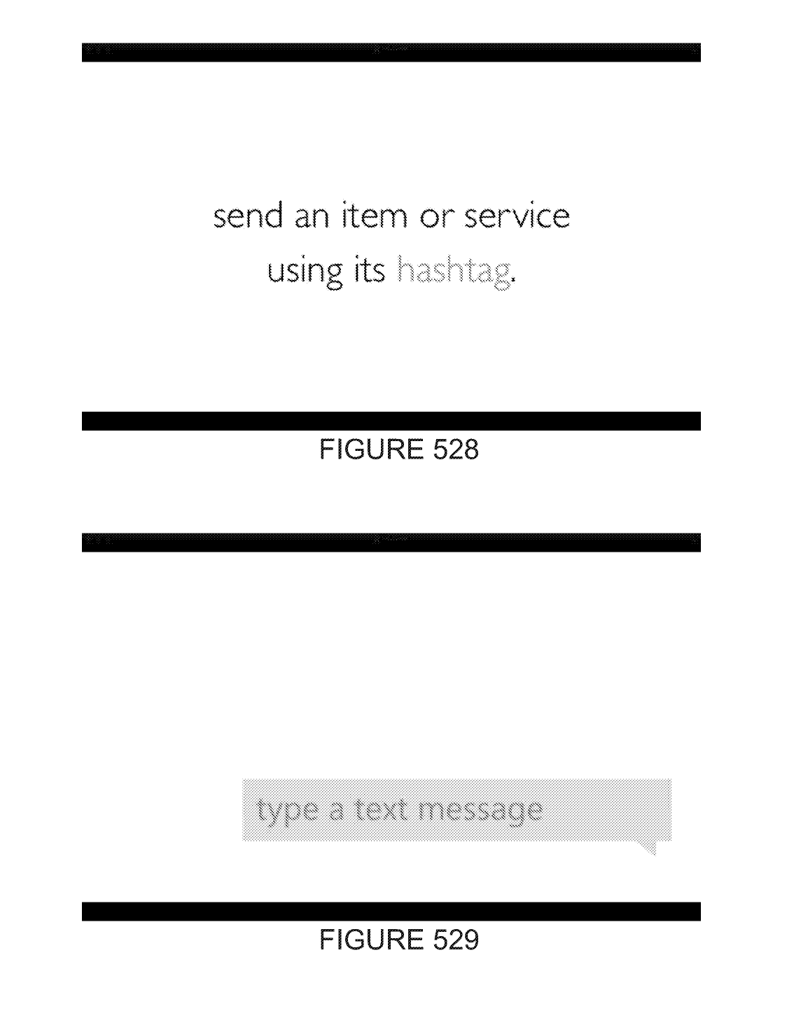

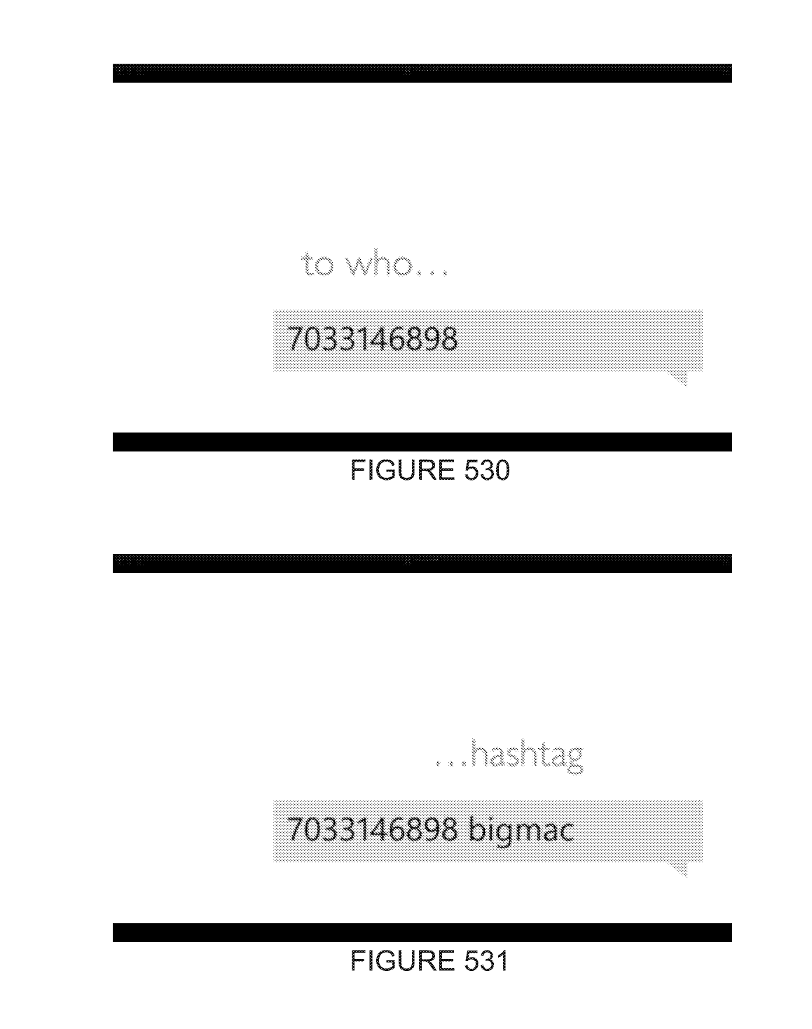

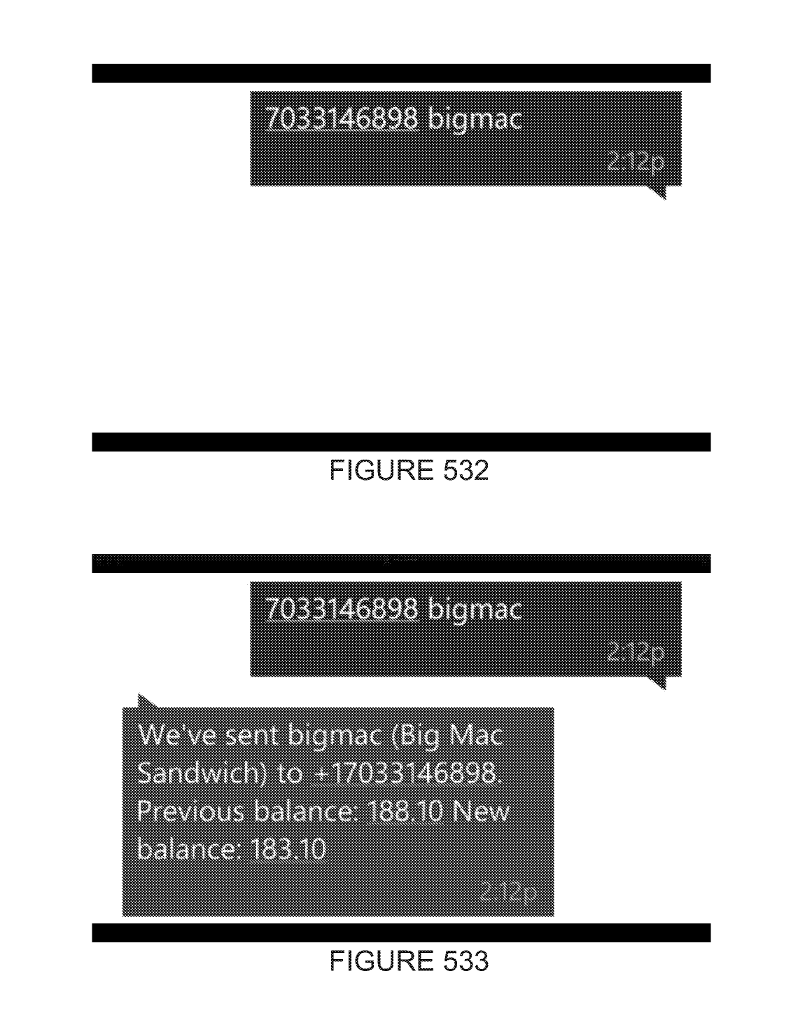

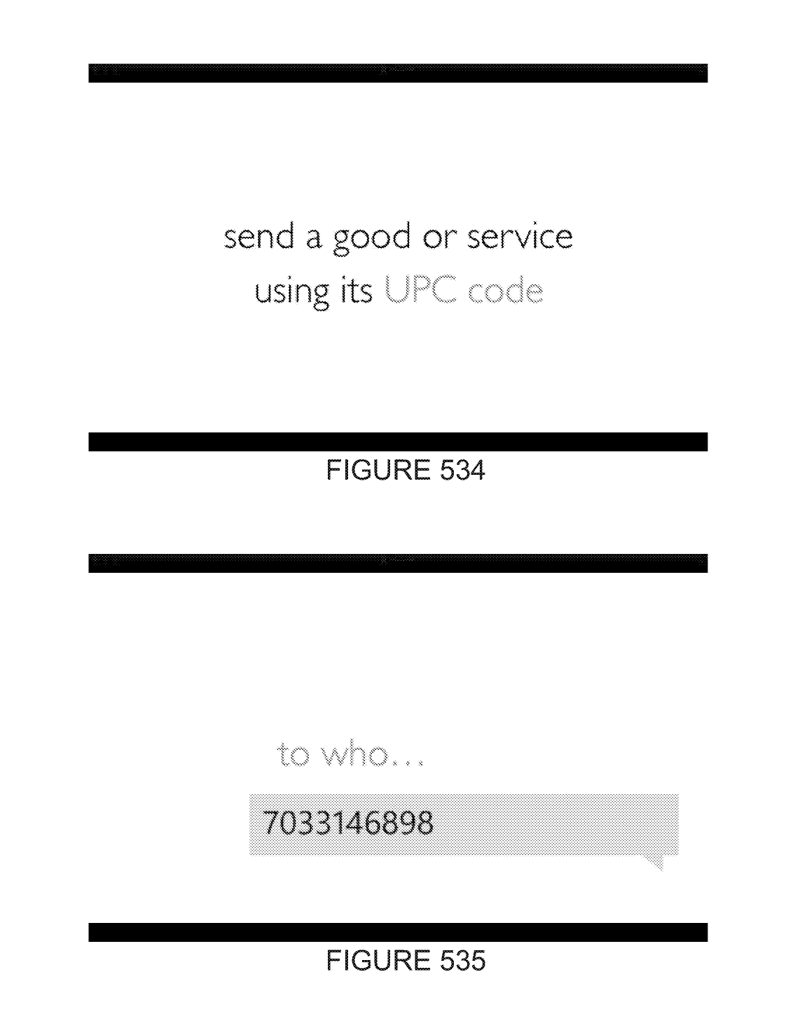

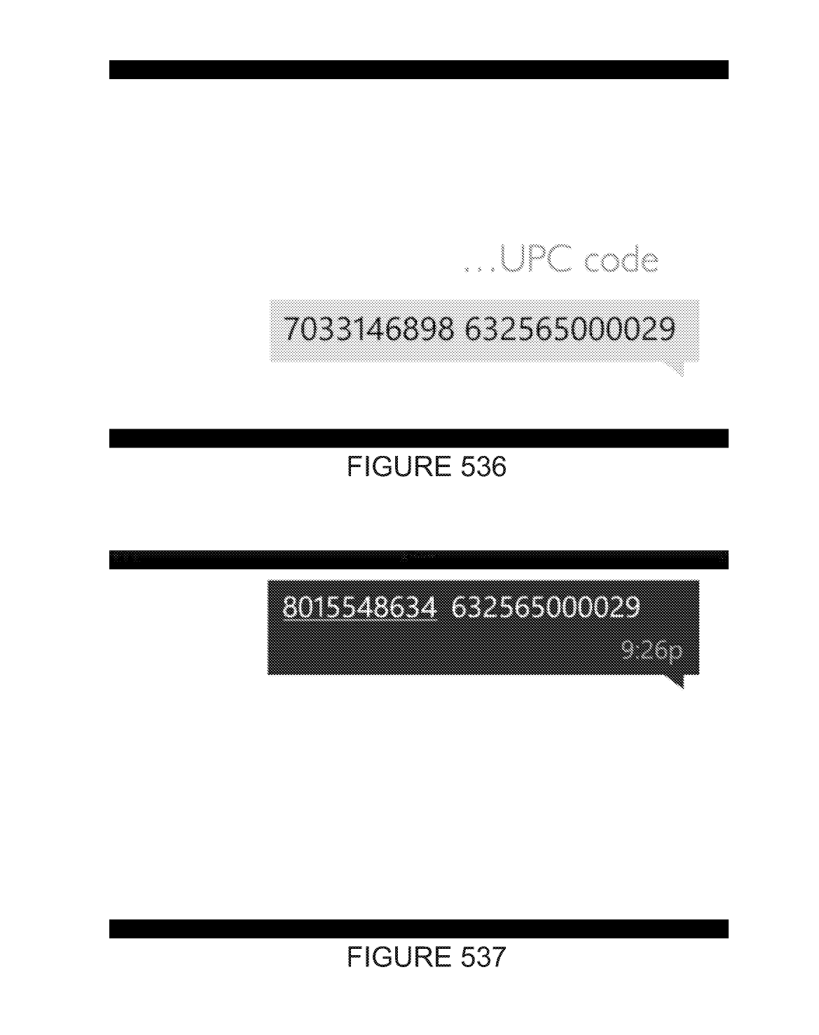

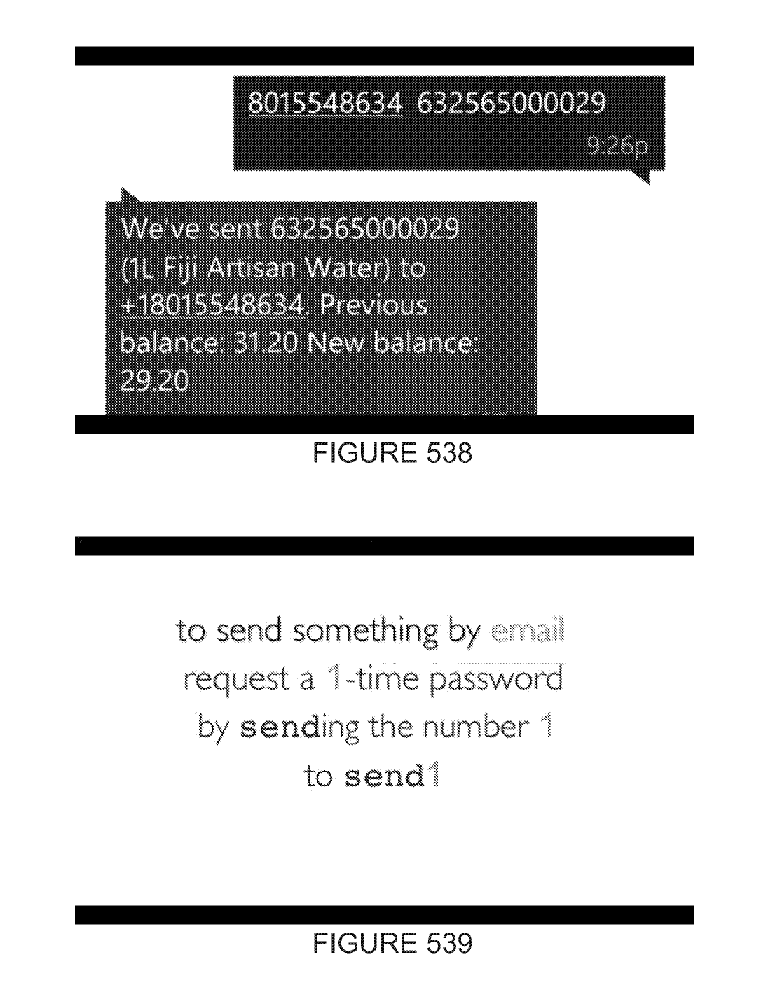

For example, communications may be sent to the recipient in one or more emails if the send request contains a recipient email address, without limitation. For example, communications may be sent to the recipient in one or more text messages if the send request contains a recipient phone number, without limitation. For example, communications may be sent to the recipient in one or more social posts or direct messaging (DM) if the send request contains a recipient social media address (e.g., “@joe155”), without limitation. For example, communications may be sent to the recipient in one or more phone calls, if the send request contains a recipient phone number, without limitation. For example, communications may be sent to the recipient via a mobile application 147 user interface 106, if the send request was made via one or more mobile application interactions, and the recipient 92 comprises a mobile device 96 comprising a mobile application 147, without limitation. Upon receipt of the recipient 92 physical address information (e.g., user data 8), system components may create an account for the recipient 92 and/or may update an existing profile 130 of the recipient to populate the received physical address information, without limitation. Some non-limiting embodiments of the inventive technology may allow the requesting user 91 to provide an item code in conjunction with the recipient's 92 physical address information (e.g., a home or office delivery address of the recipient), in a single communication. For example, as a continuation of the aforementioned example, a user 91 may, in some embodiments, provide a send request communication to the system containing the instruction “FTDbouquetsmall 512 Pendleton Street STE 2 Alexandria Va. 22314”. The send request communication may be made by the requesting user 91, for example, in an SMS message, mobile message, in an email (e.g., subject and/or body field), and/or in a social post to a system address, such as a Tweet or direct message to a system electronic address (e.g., “@send1 now”), without limitation. In yet further embodiments, a requesting user 91 may provide a send request communication to the system containing the instruction “yXd62D FTD bouquet small 512 Pendleton Street STE 2 Alexandria Va. 22314” for example, in the body of a text message to the system or in the subject line of an email to the system, wherein “yXd62D” may comprise a one-time verification code delivered by the system, without limitation. In some embodiments, “yXd62D” may comprise a semi-permanent or permanent security feature, without limitation. The security feature may be, for example, a user-created password, a user-created PIN, a system-defined password, a system-defined PIN, a function code, a code or portion of a code provided to a card 19 of the user 91, and/or the like, without limitation. A number of possible combinations of security features and/or instructions are anticipated. For example, as one non-limiting example, a requesting user 91 may place recipient physical address information in the body of an email to the system or may place recipient physical address information in the subject line, with the same effect (e.g., same output 5), without limitation. As another non-limiting example, a requesting user 91 may place physical address information before the item code in an SMS-based transaction request to a system short code, or may place physical address information after the item code in an SMS-based transaction request to a system short code, with the same effect (e.g., same output 5), without limitation. In some embodiments, it may be preferable to define an easy-to-remember system formatting convention, that is, a particular order for providing security features, recipient electronic addresses, redemption information, and/or item code information in transaction requests made to the system, without limitation. As shown in some of the illustrated non-limiting exemplary embodiments (e.g., FIGS. 516-538), a convention may comprise, for instance, a “[to who?] [what]” convention. For example, the “[to who?] [what]” convention may be employed, without limitation; wherein the first provided text in a character string may comprise an electronic address of a recipient, and wherein latter provided text in a character string may comprise an amount, an item code, a UPC barcode, and/or redemption information 64 (e.g., a redemption code) to be sent to the preceding electronic address. A space may be provided between the electronic address and the amount/item code/UPC barcode/redemption information in order to reduce the complexity of parsing algorithms, and/or to comply with the “[to who?] [what]” convention, without limitation.

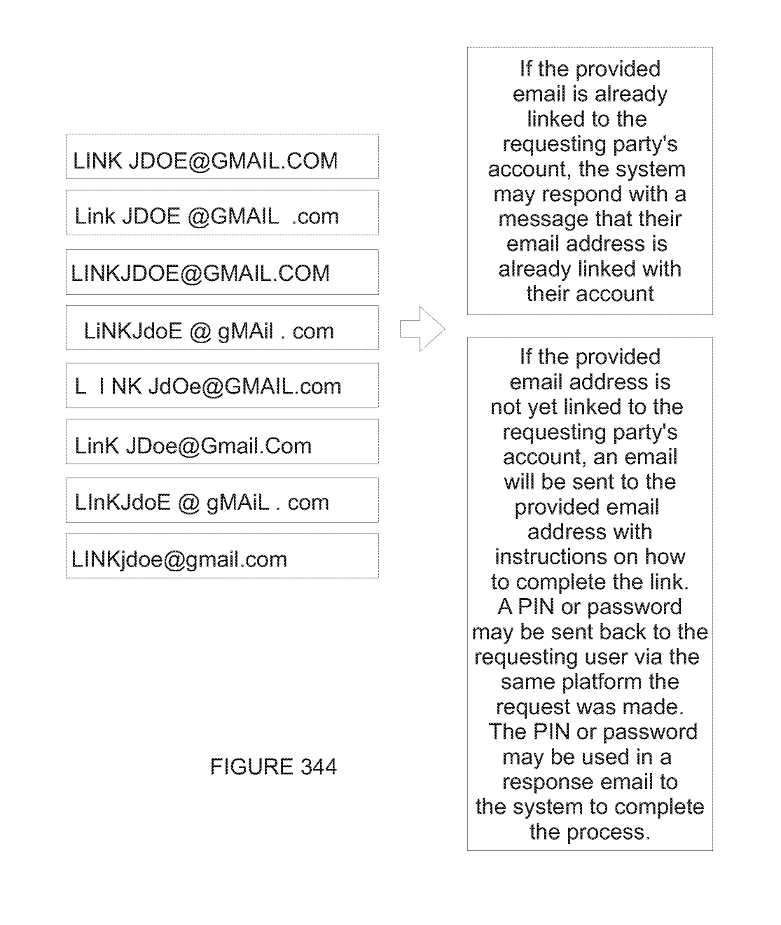

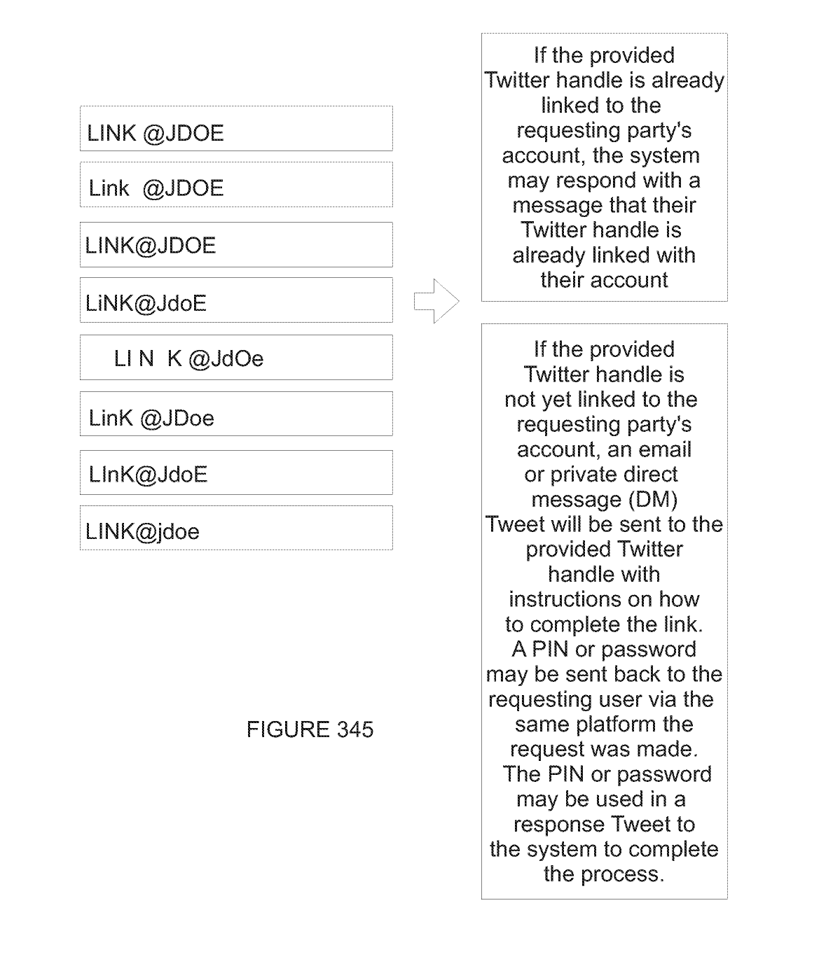

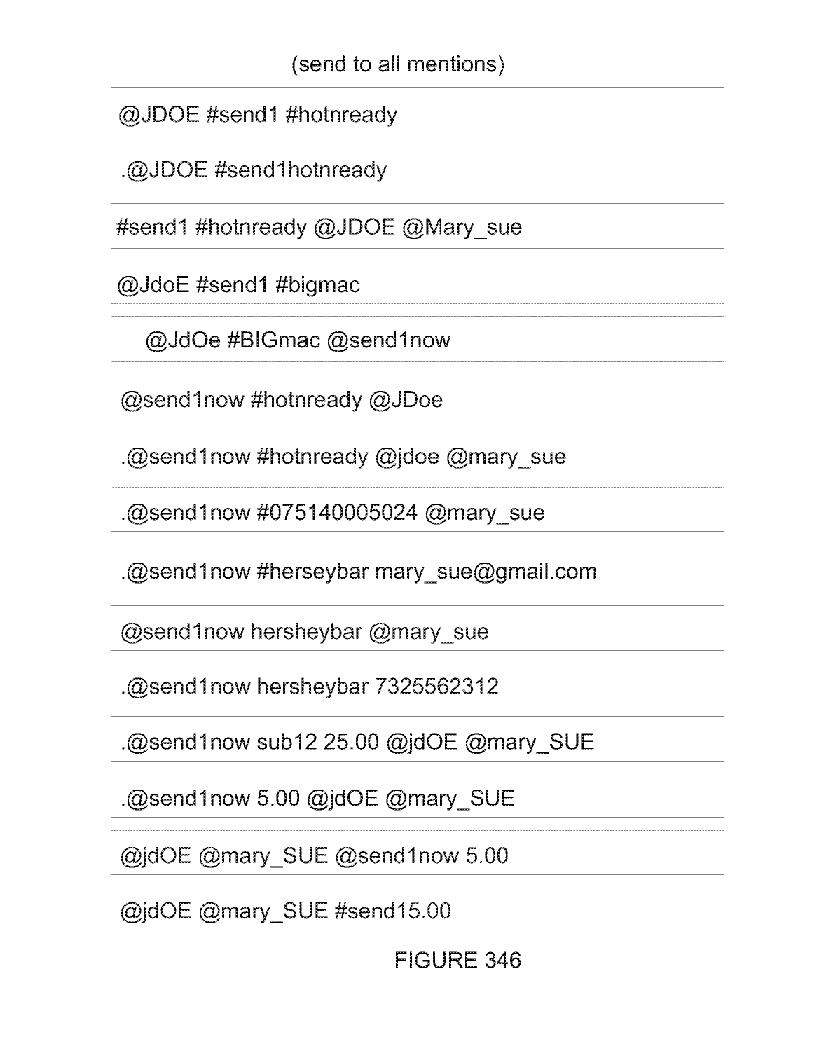

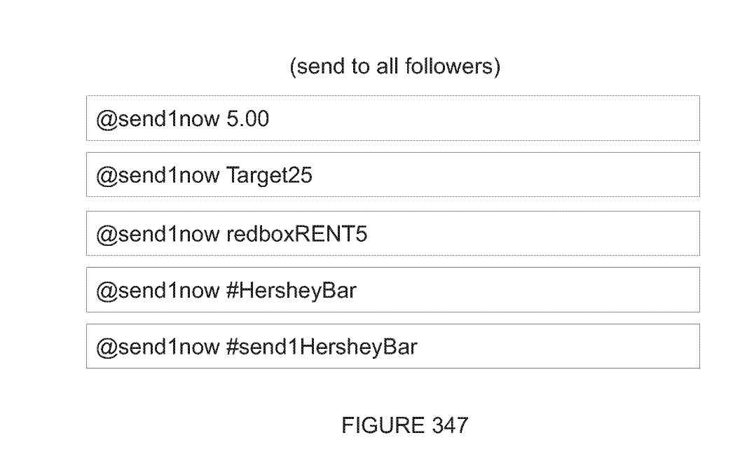

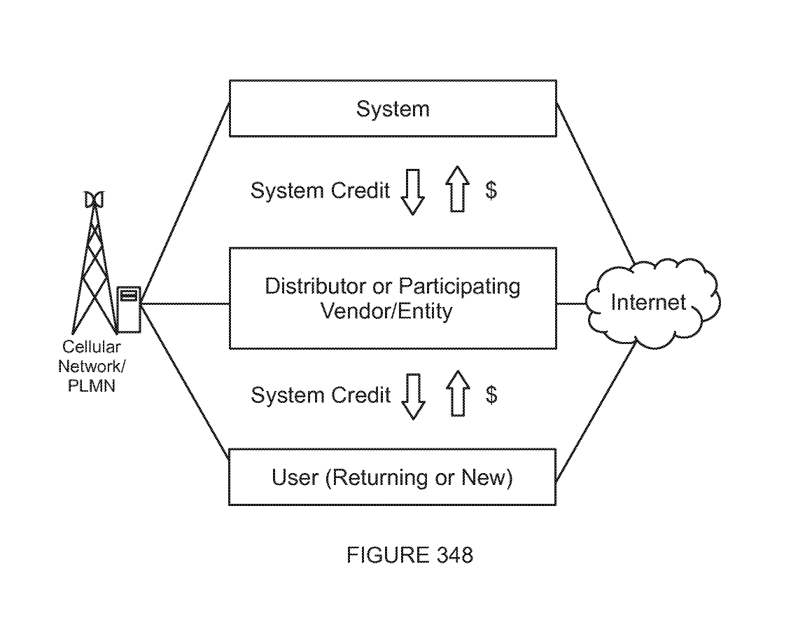

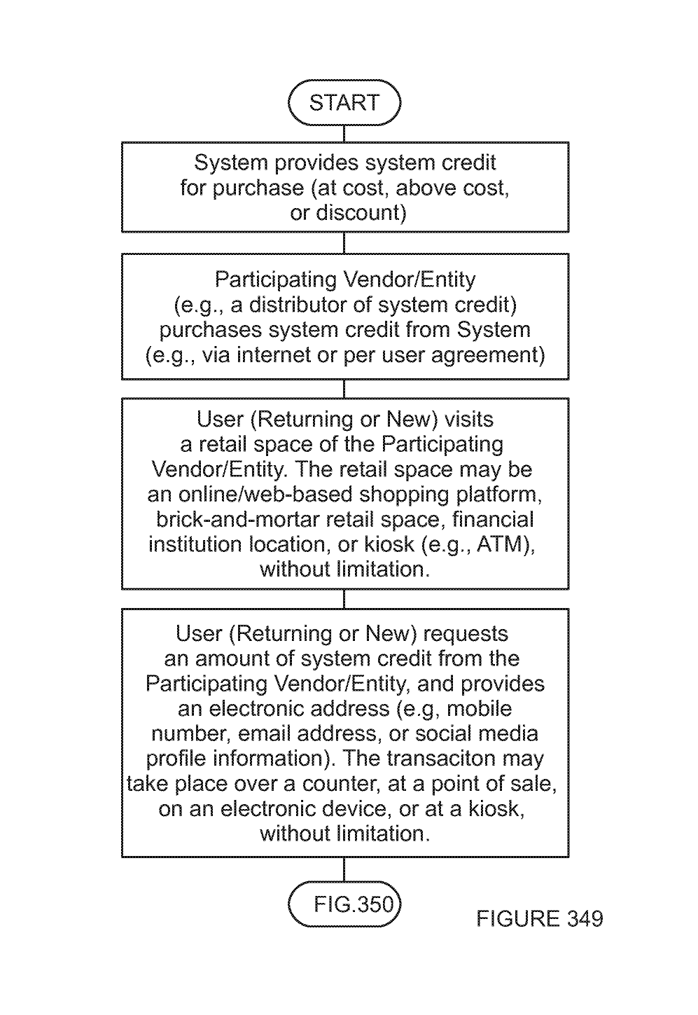

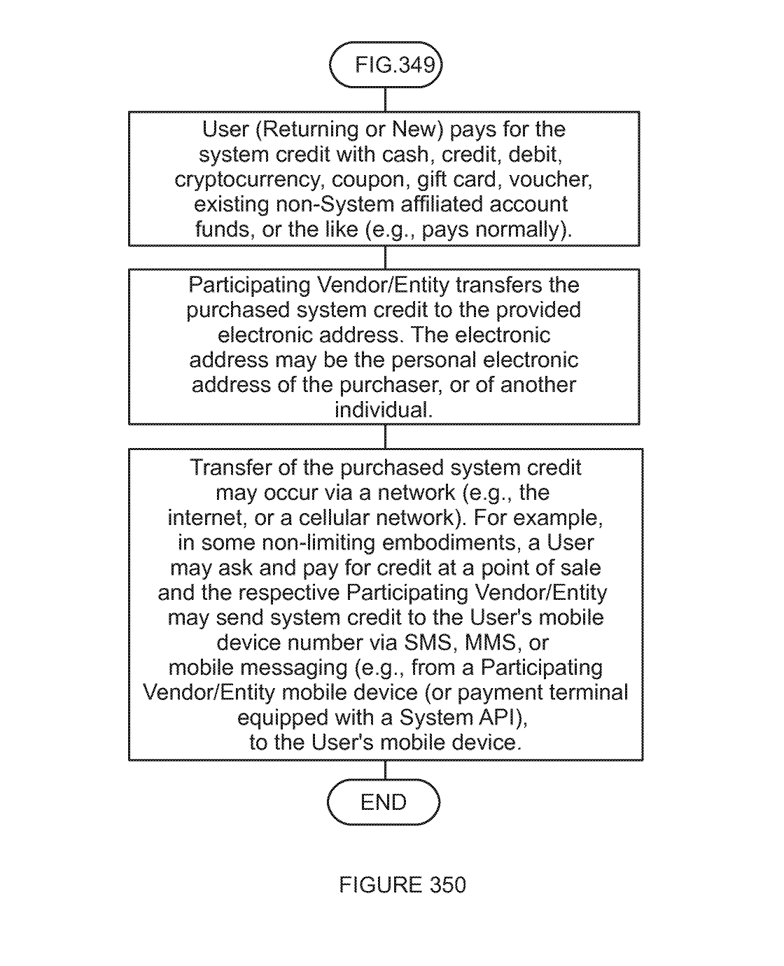

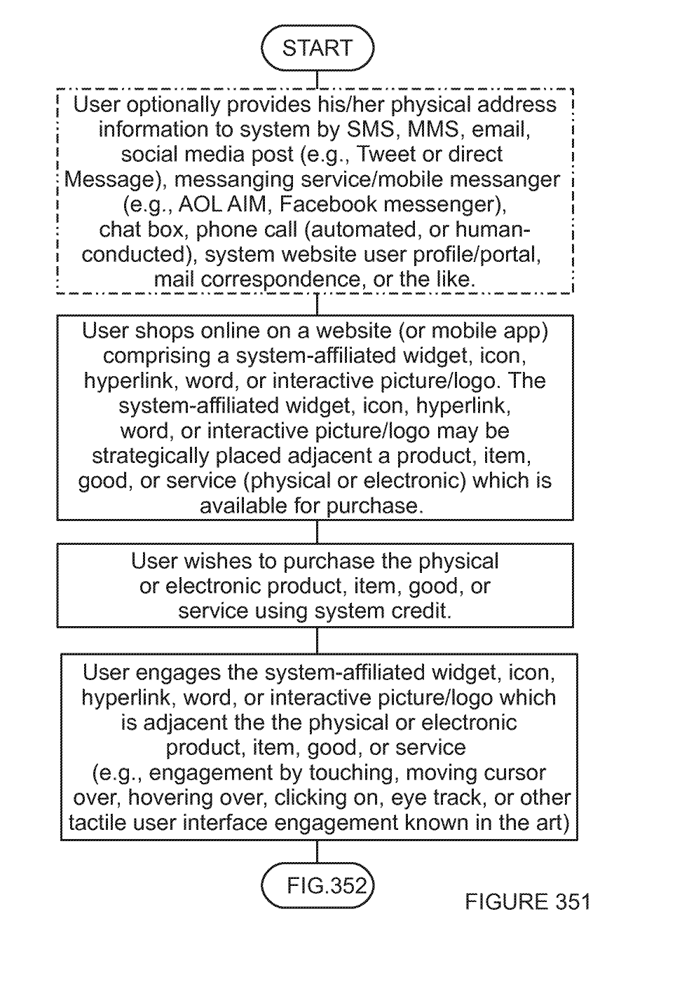

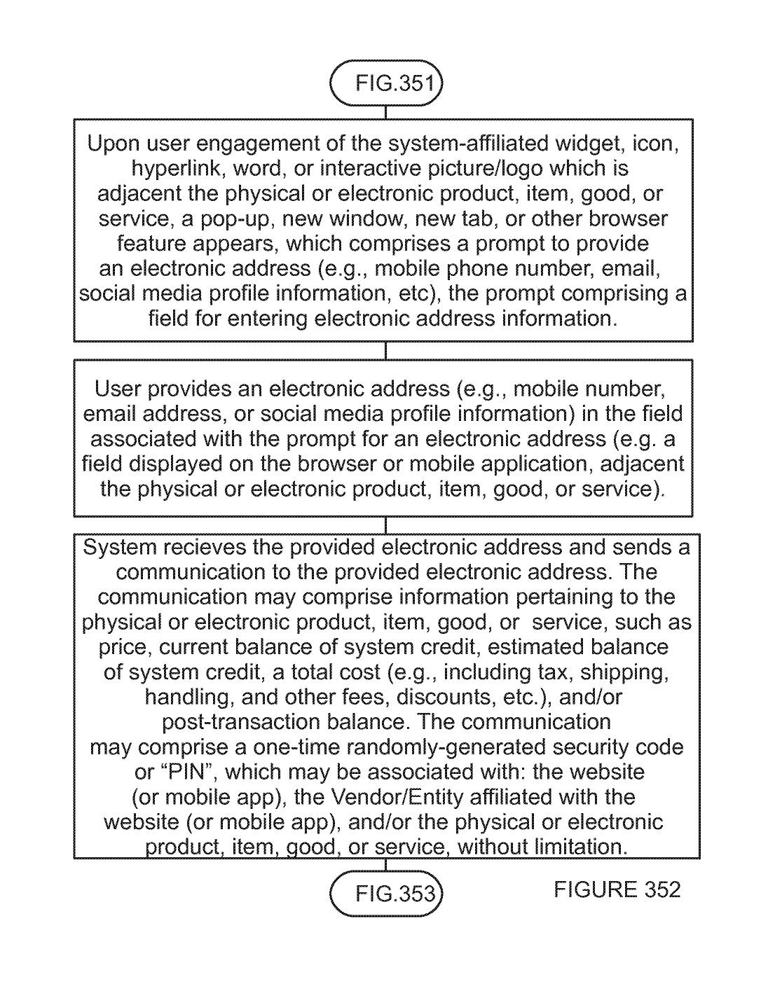

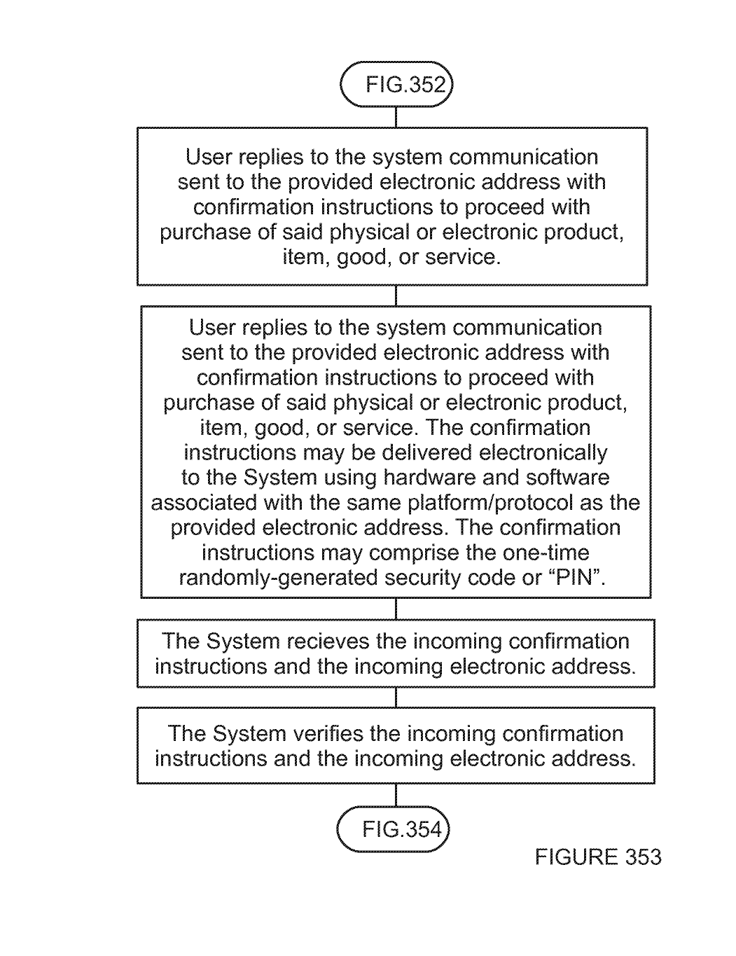

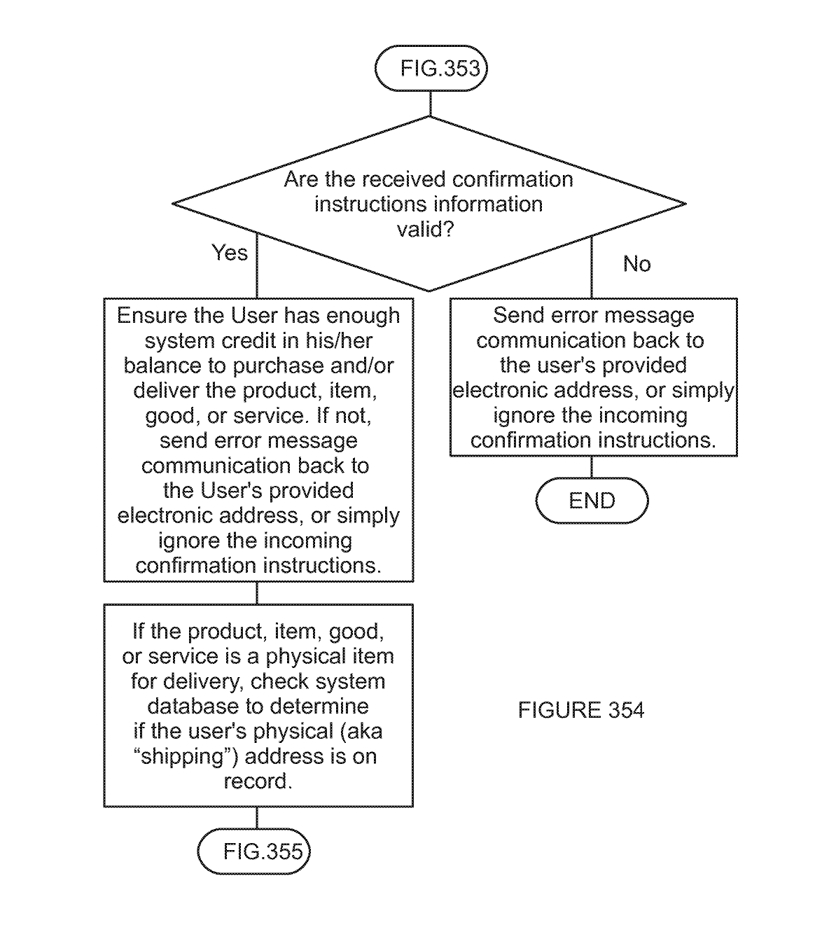

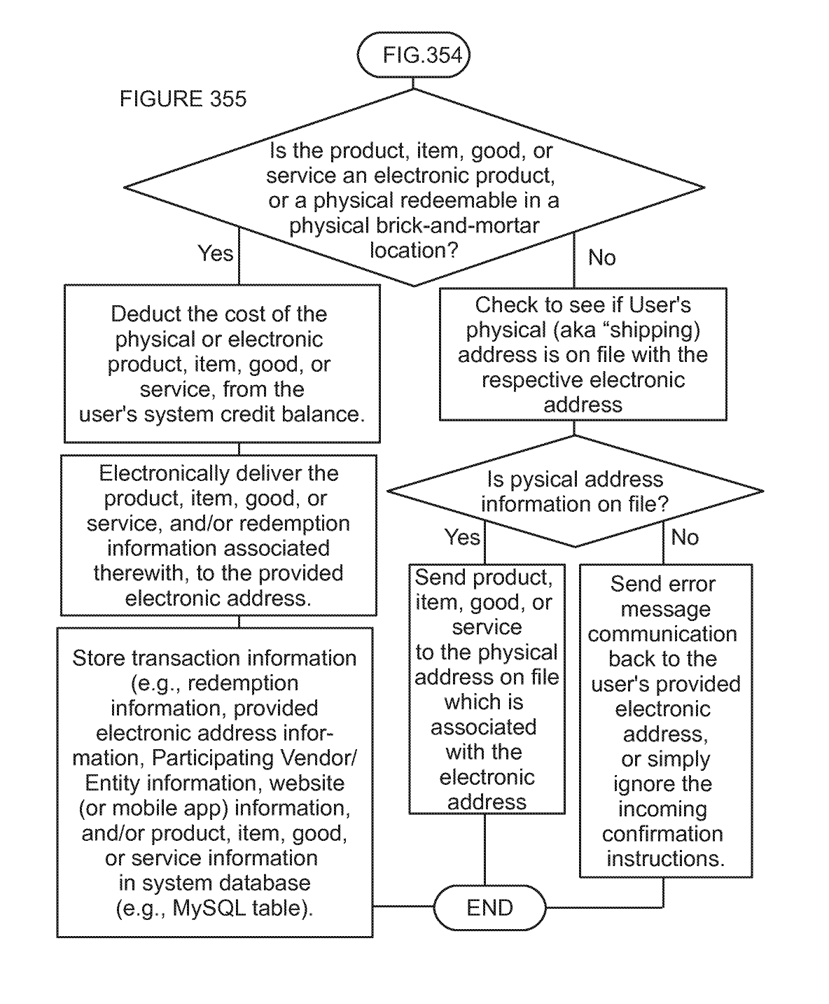

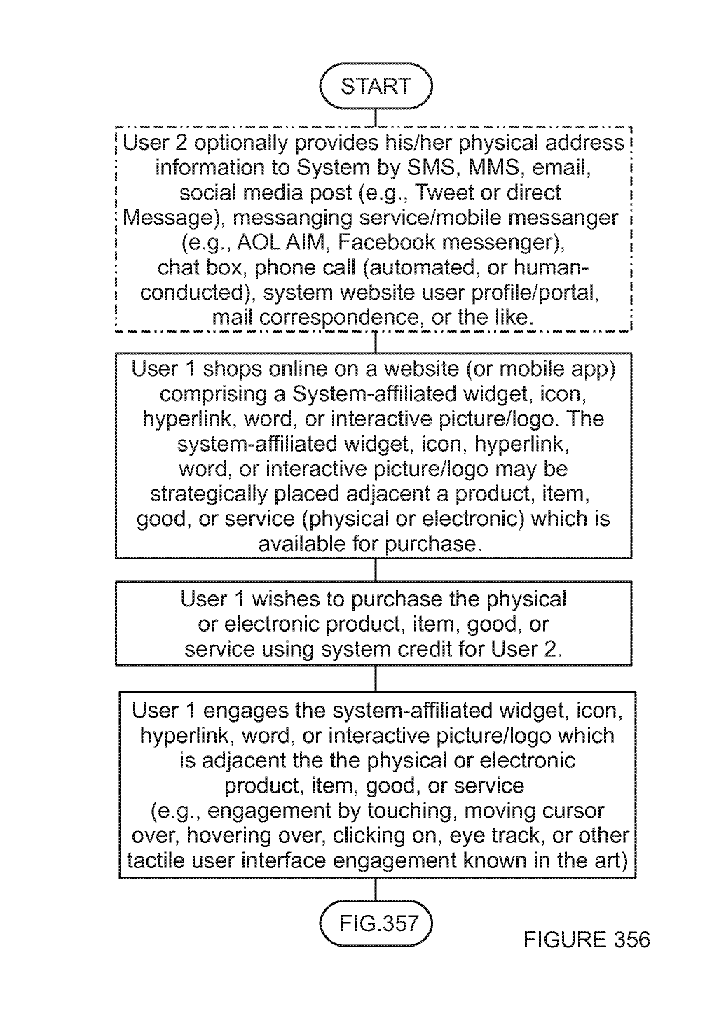

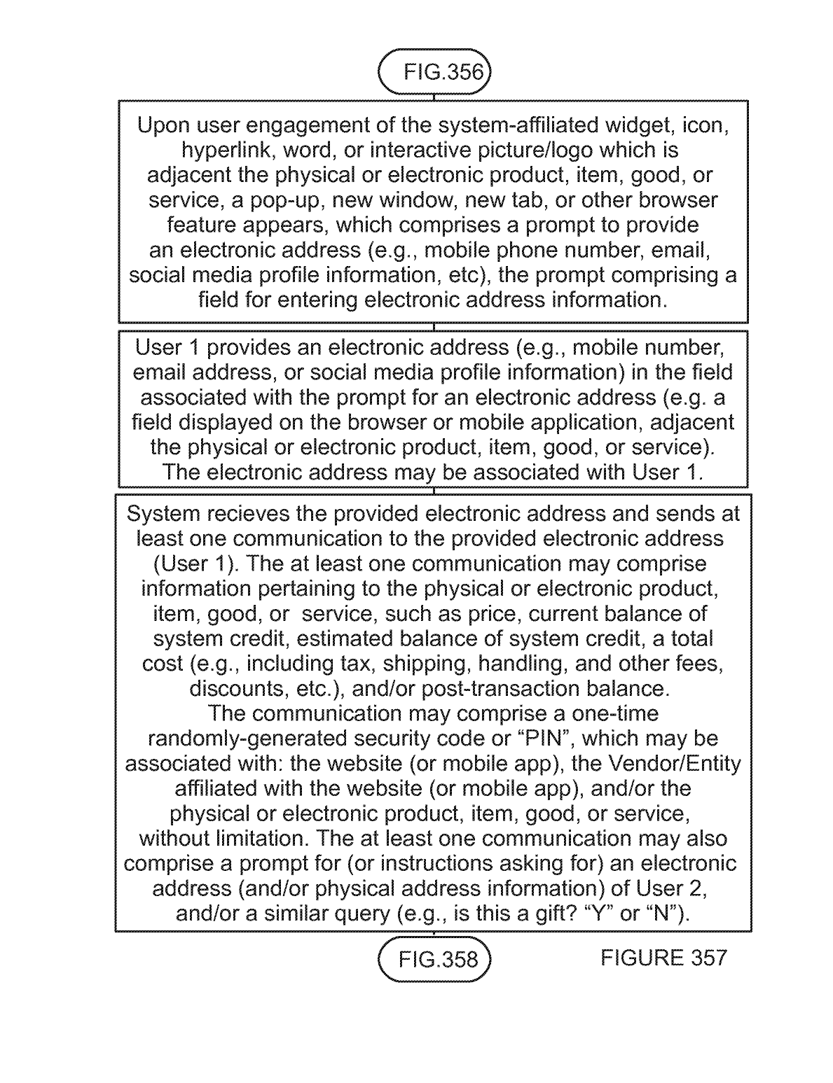

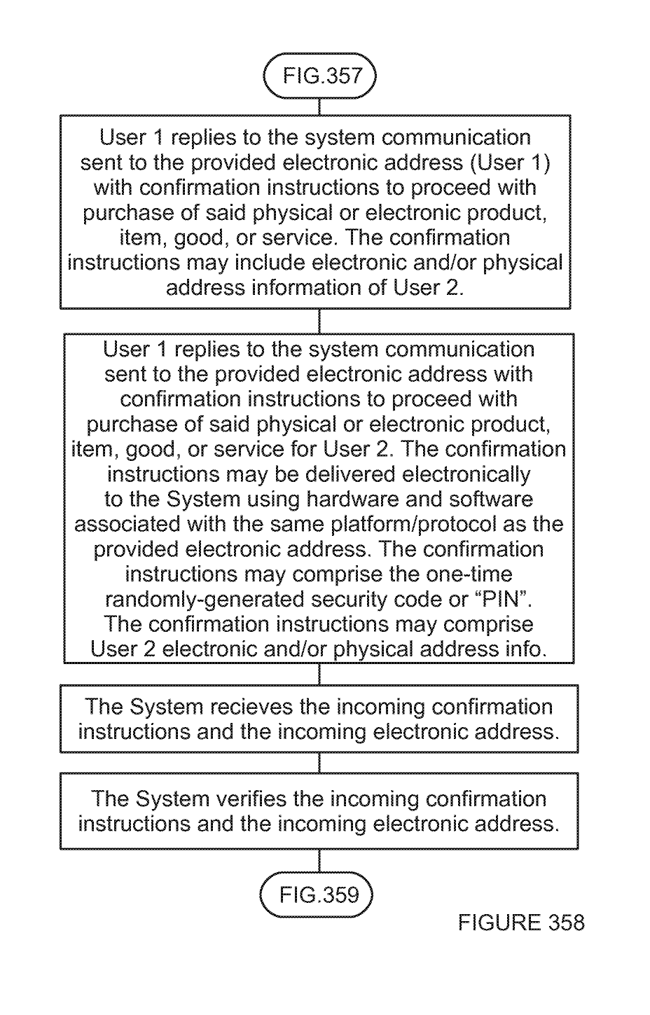

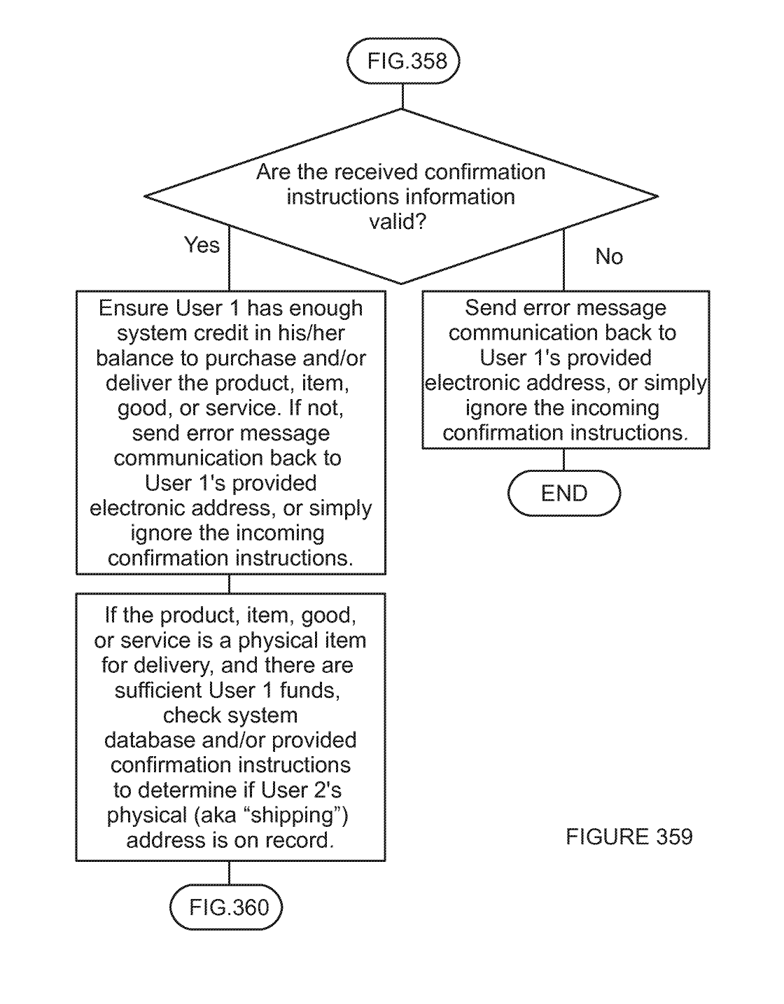

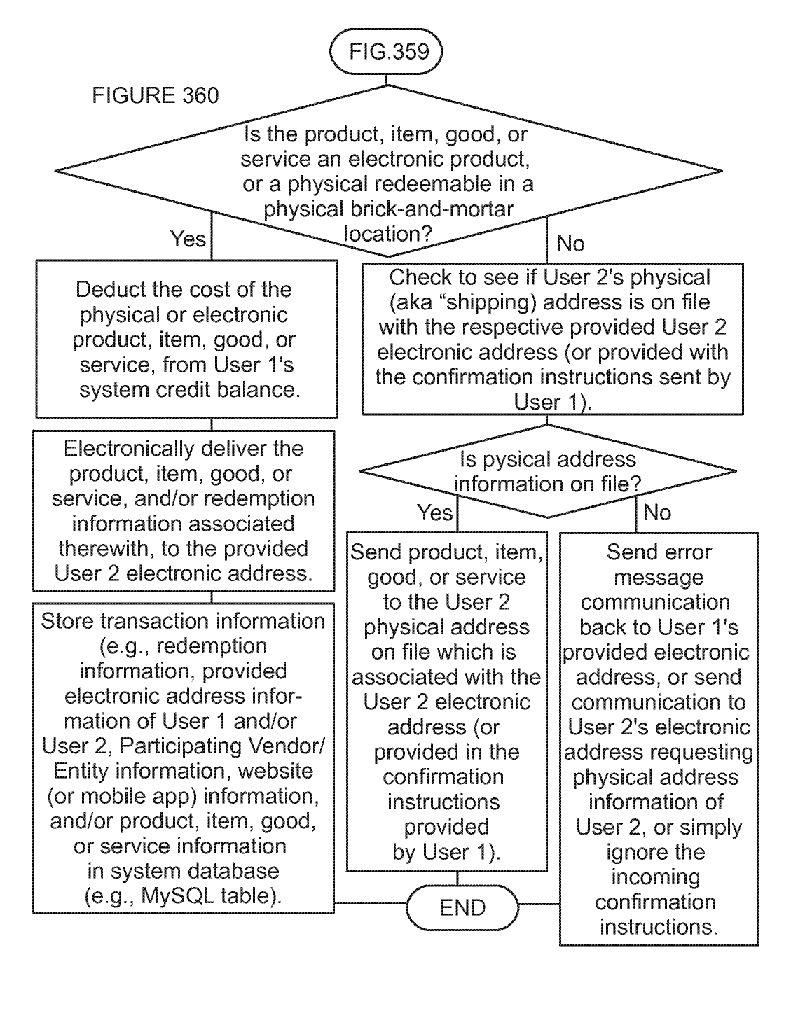

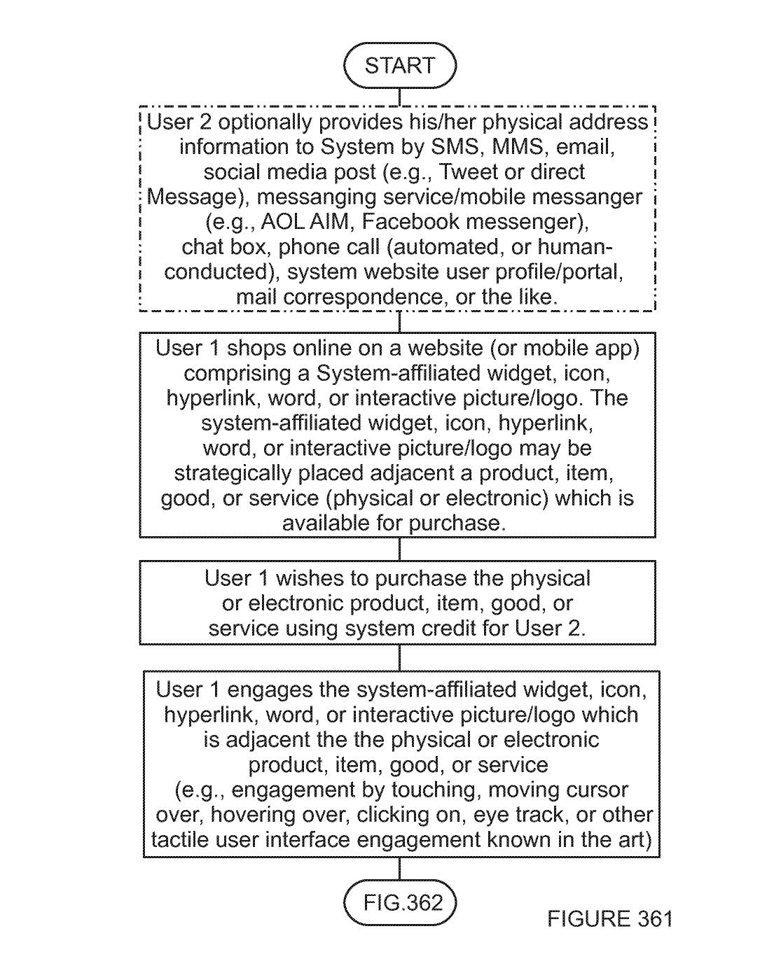

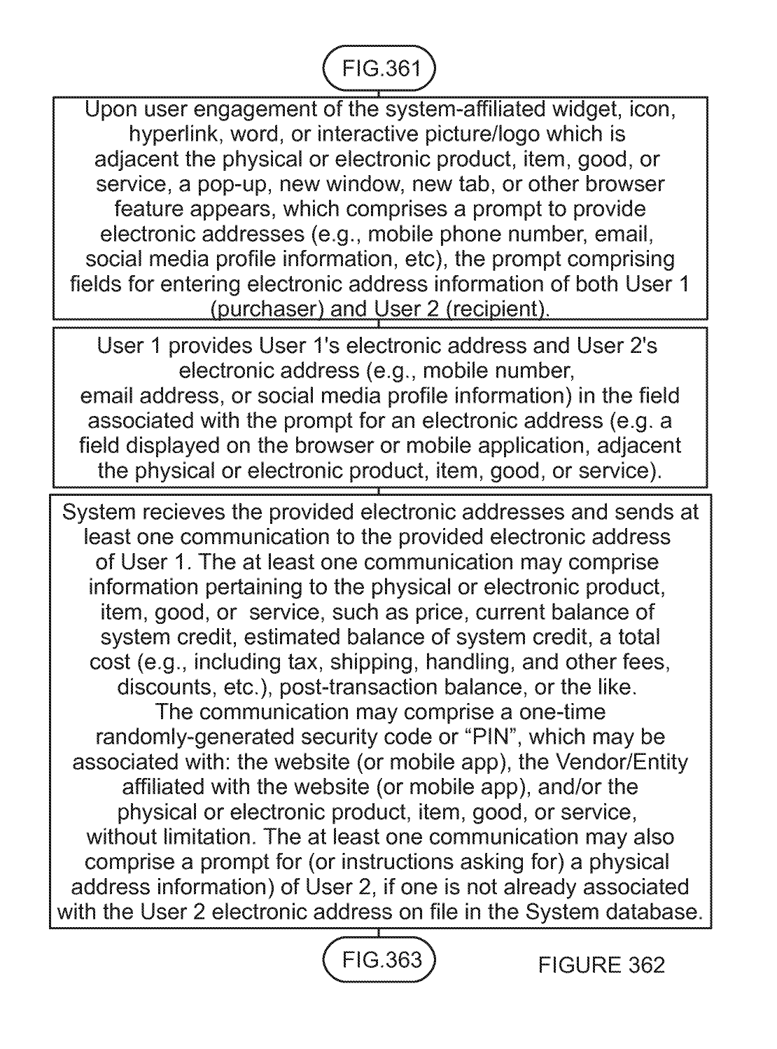

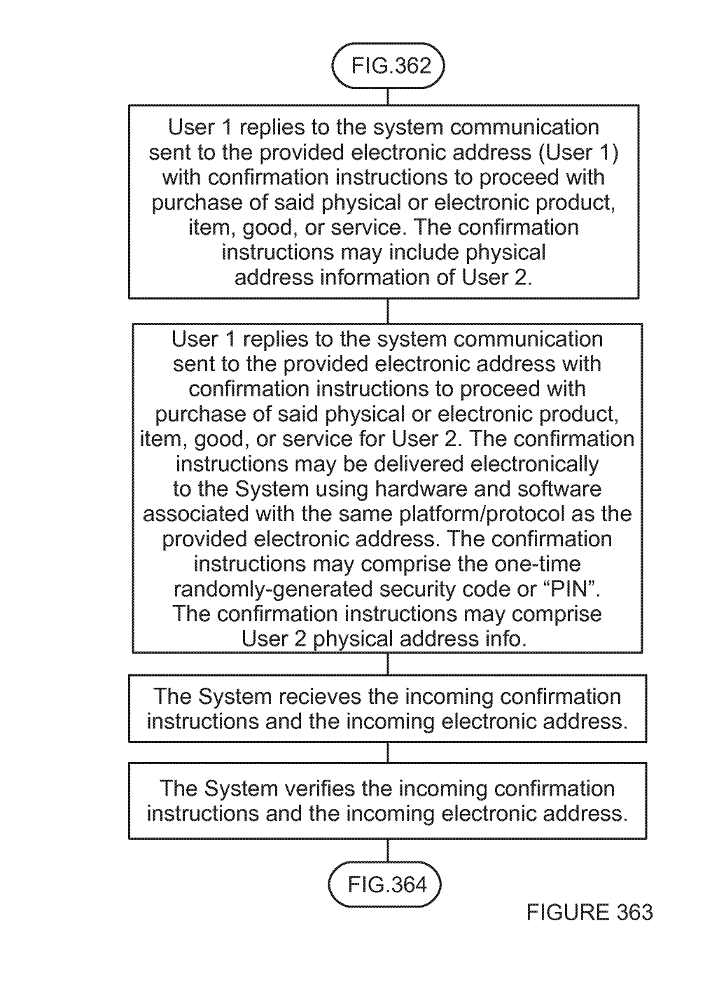

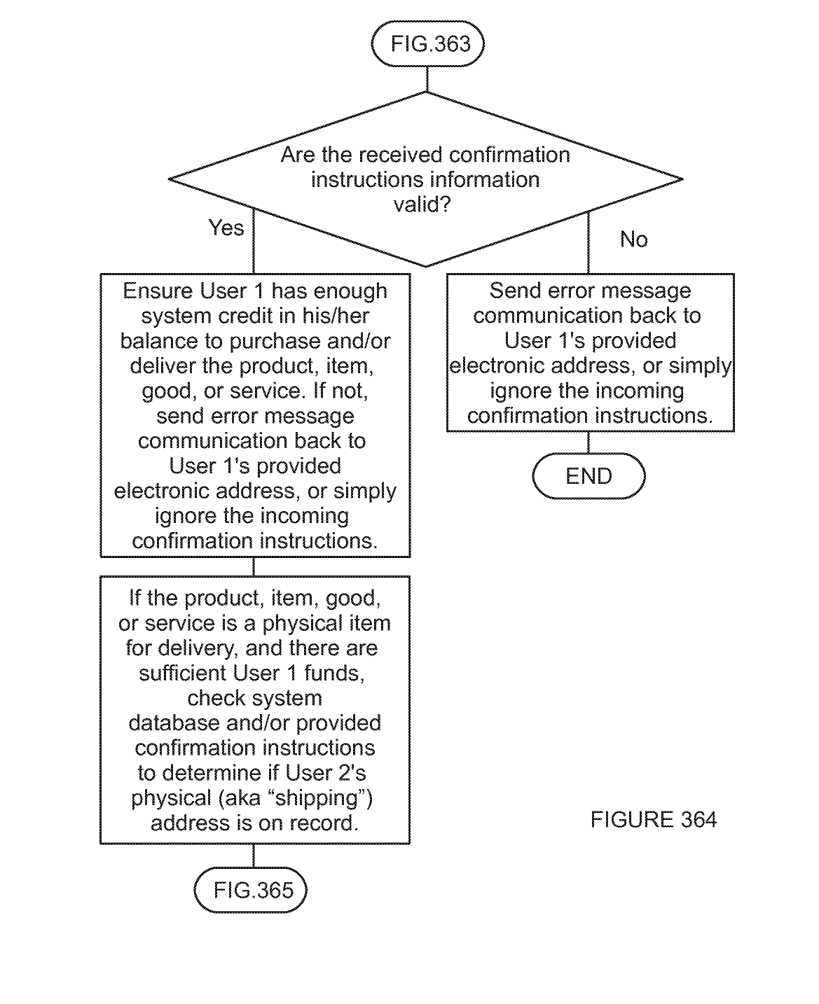

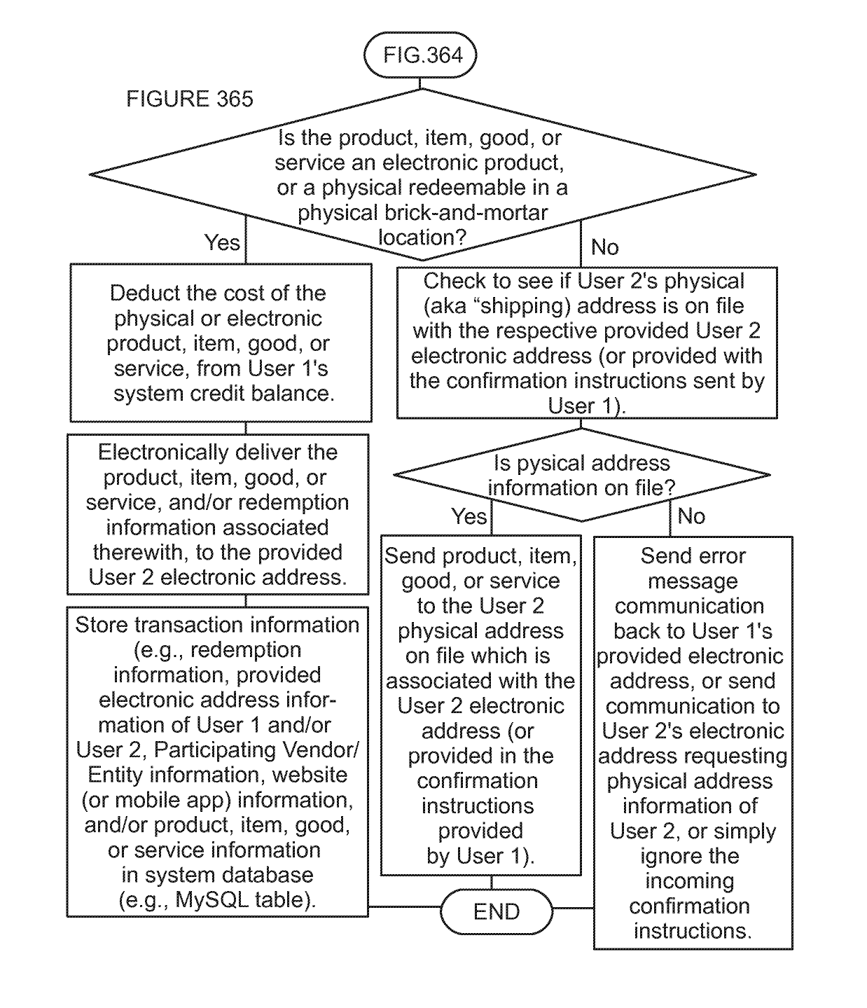

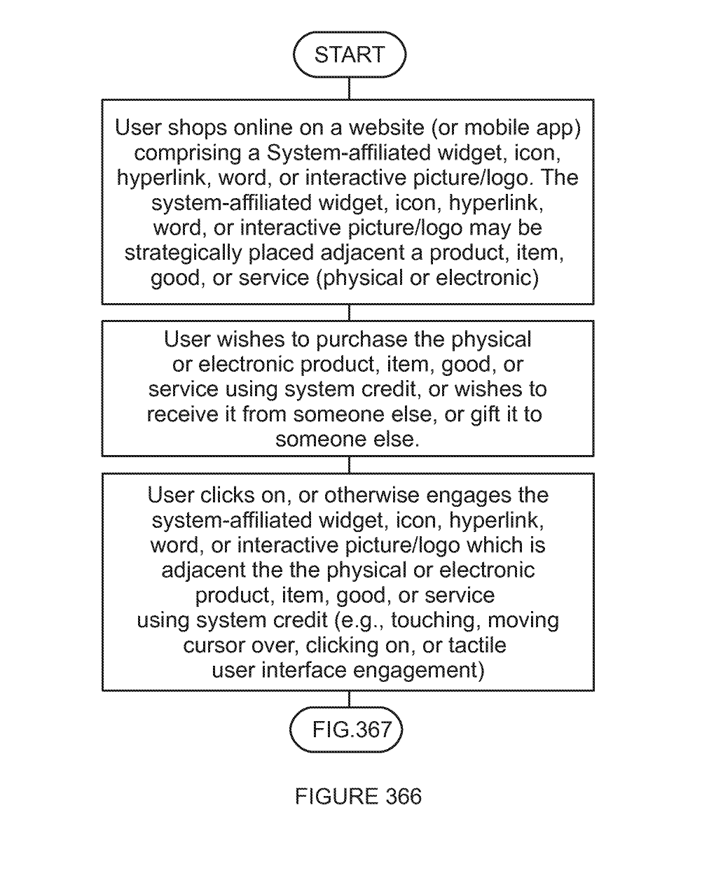

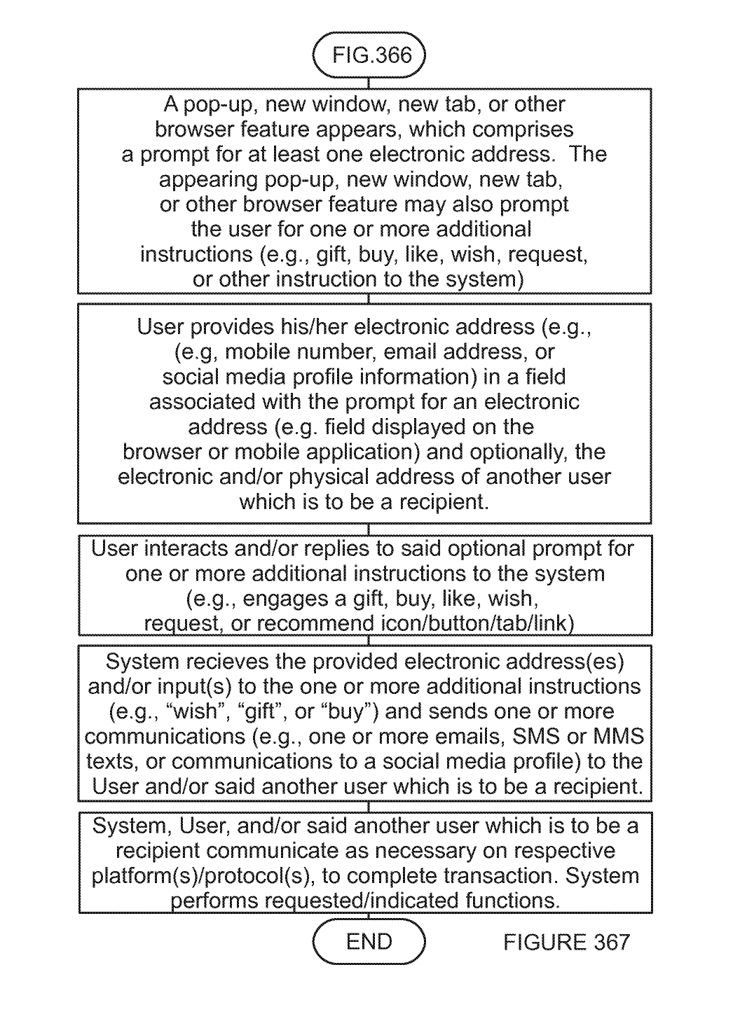

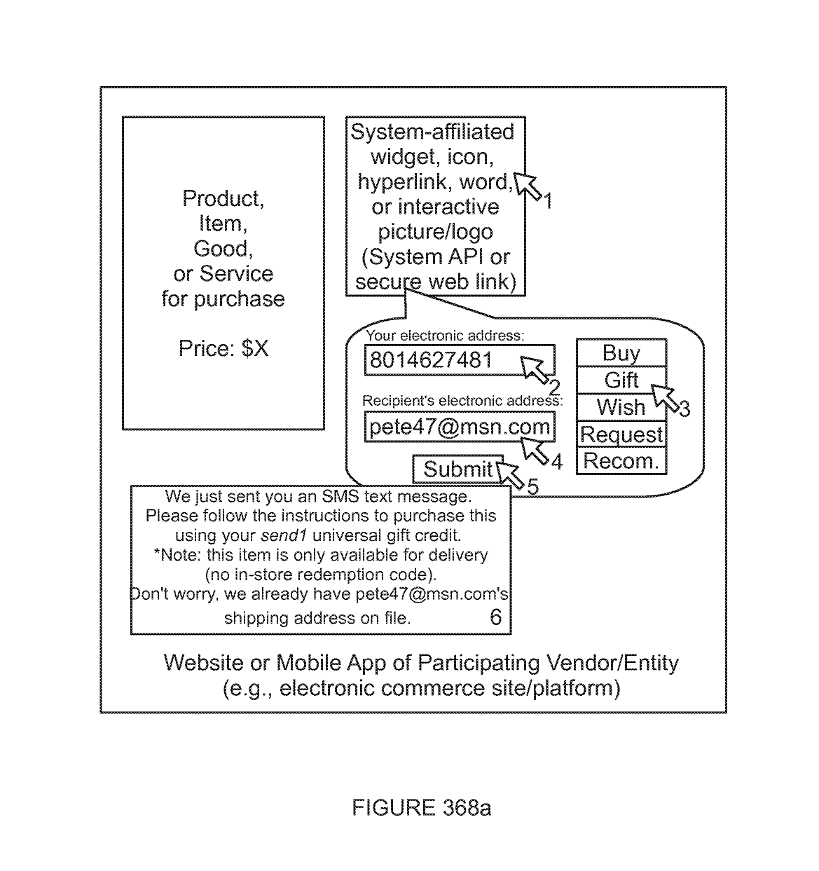

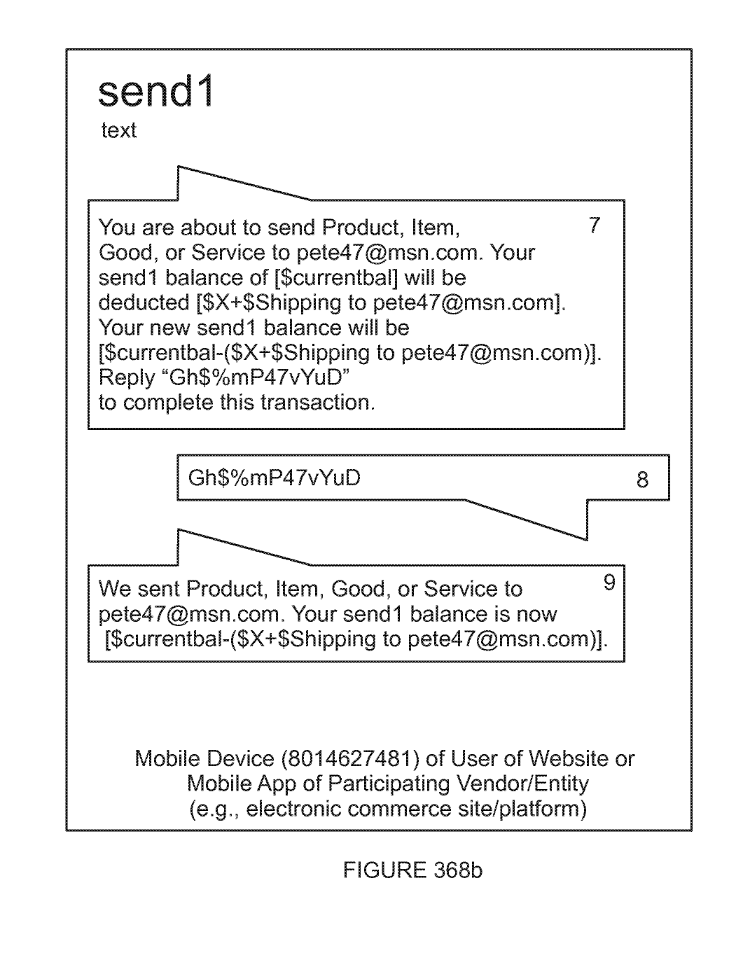

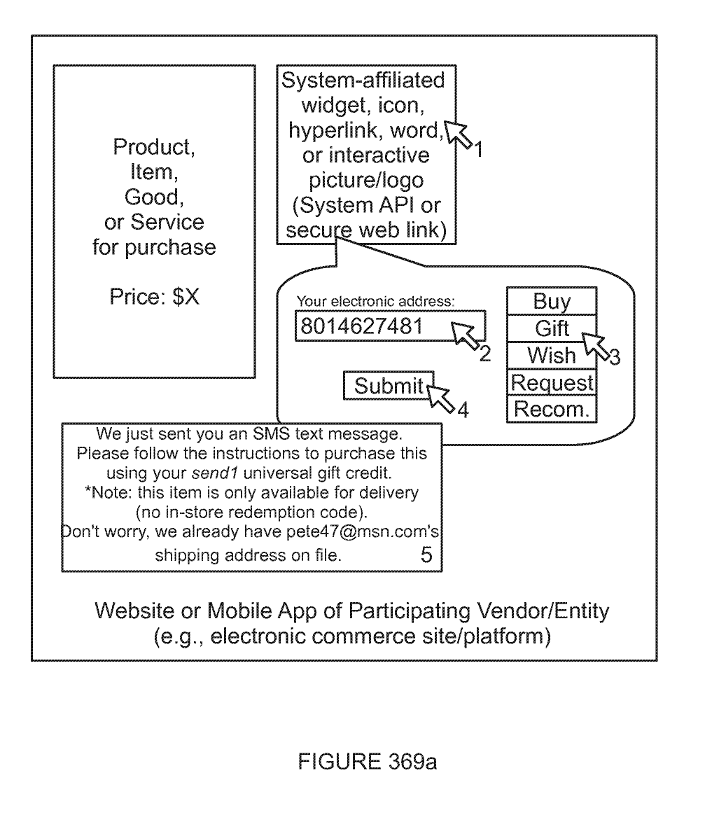

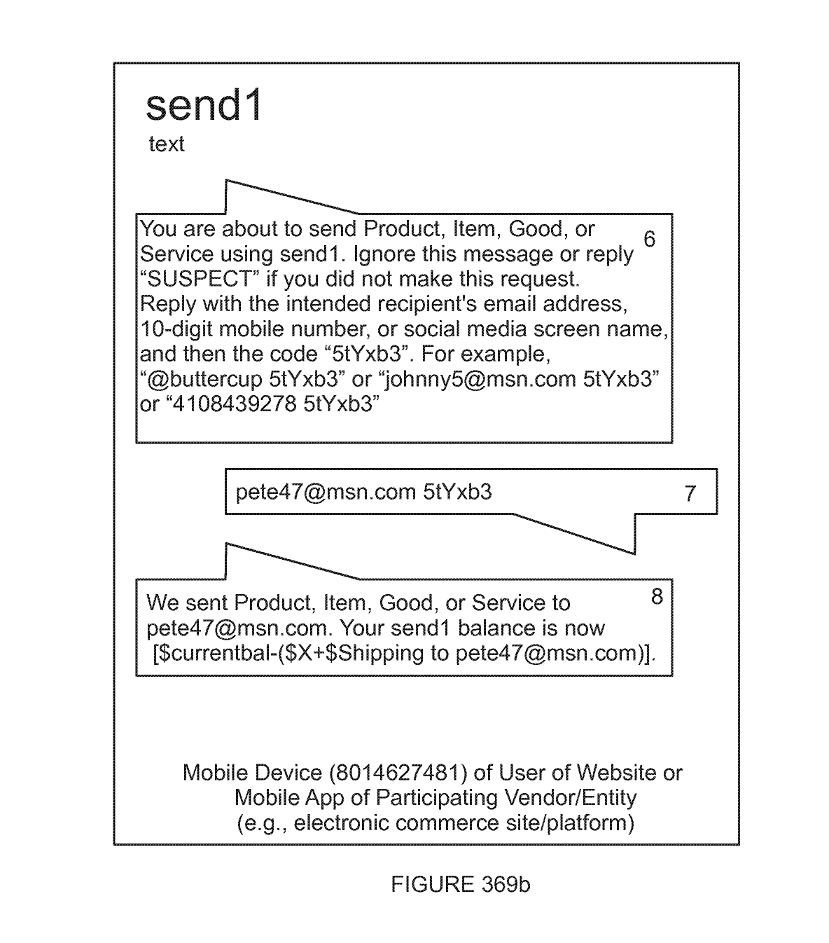

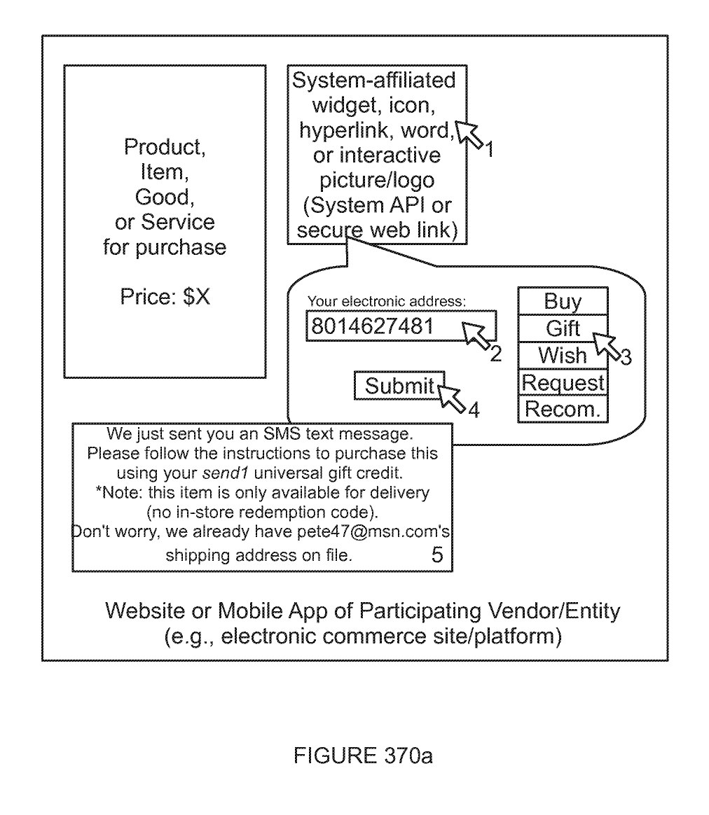

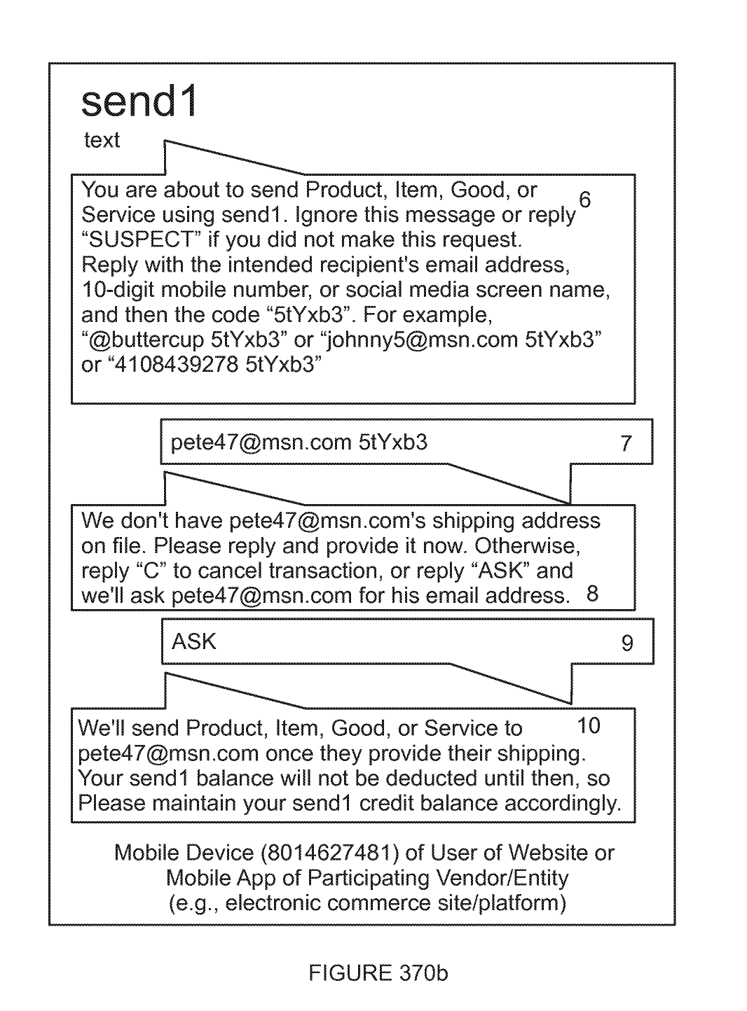

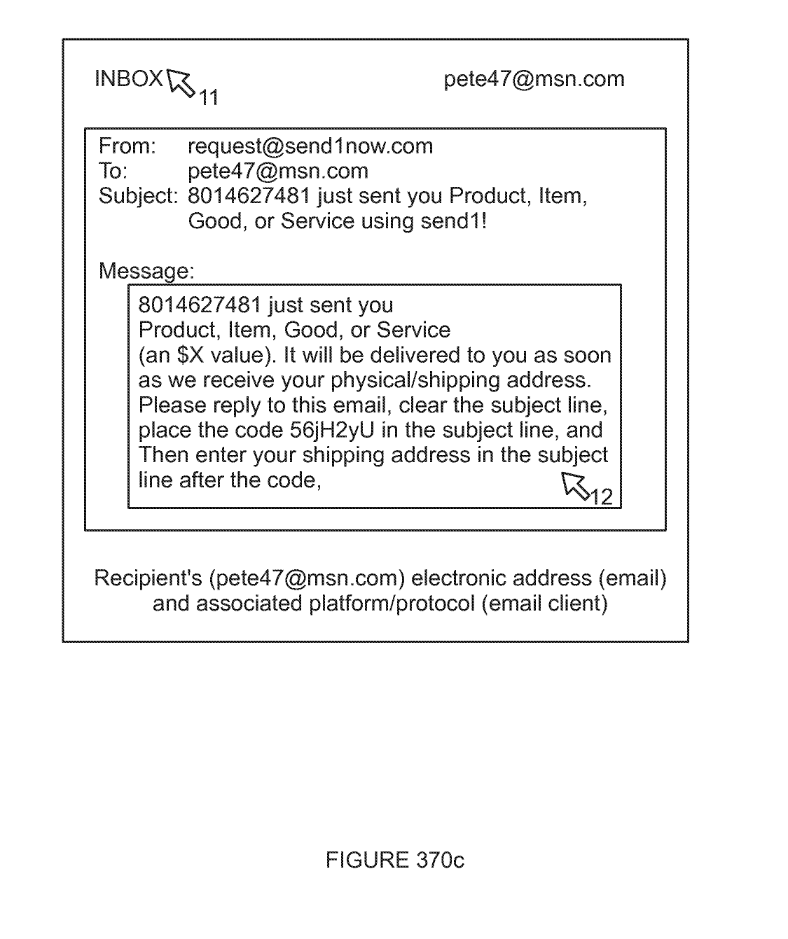

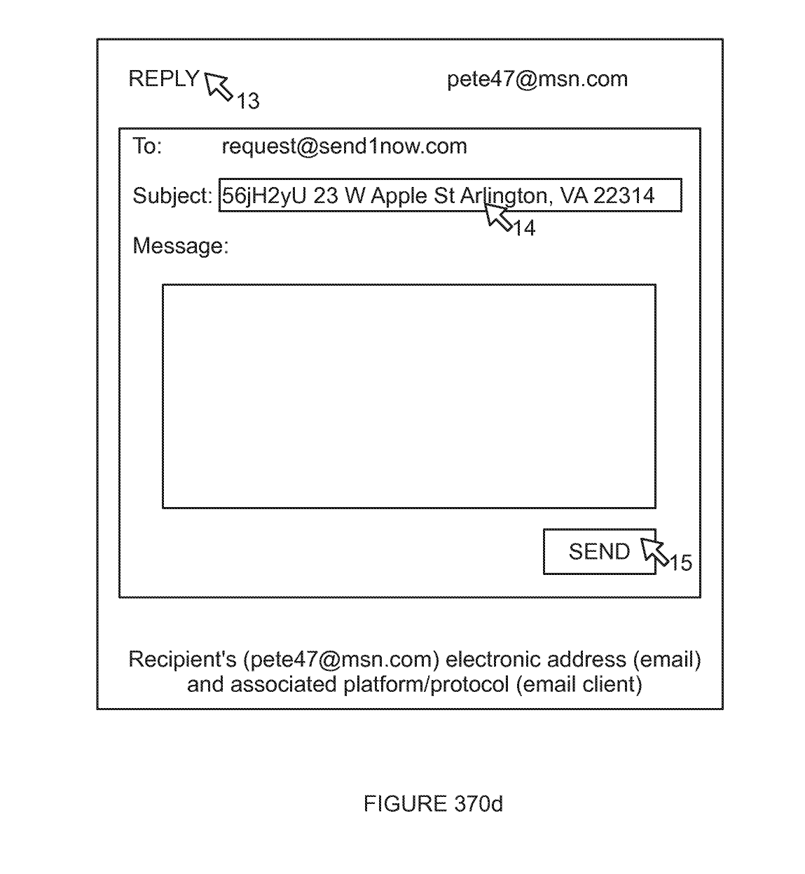

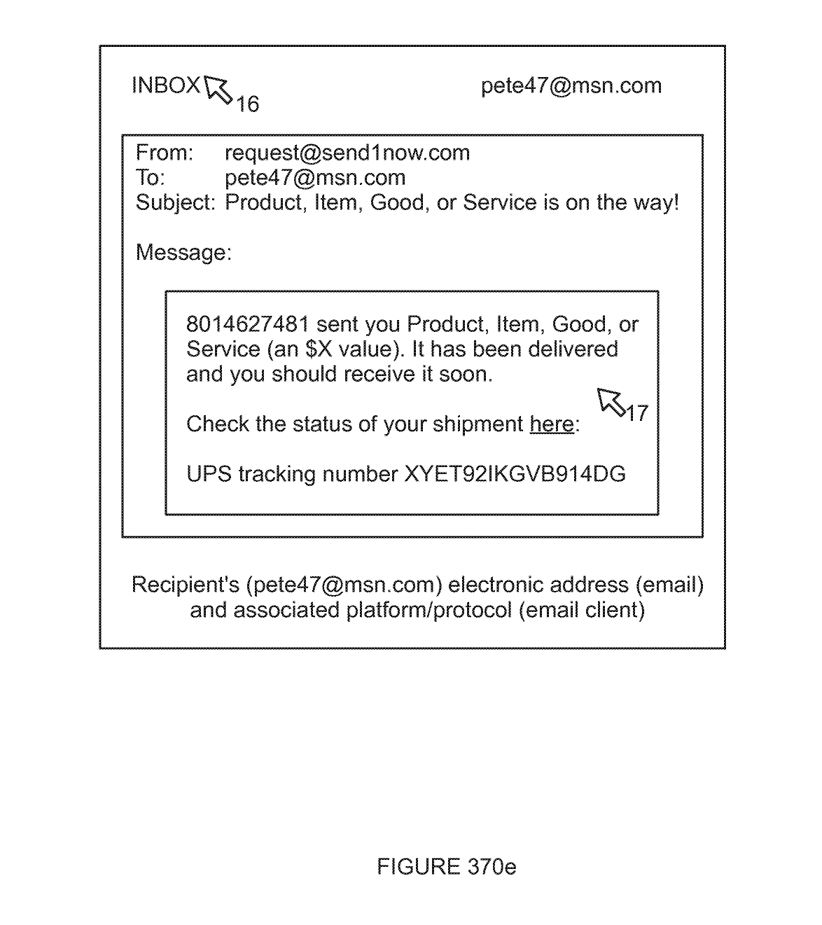

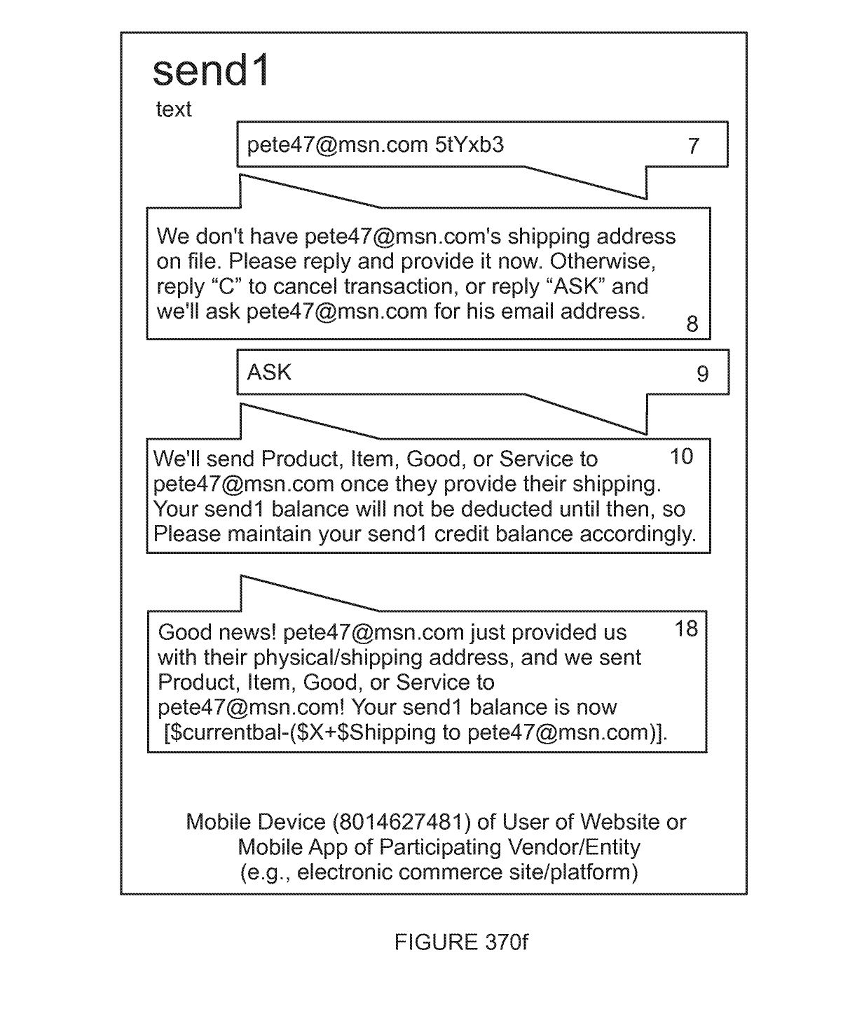

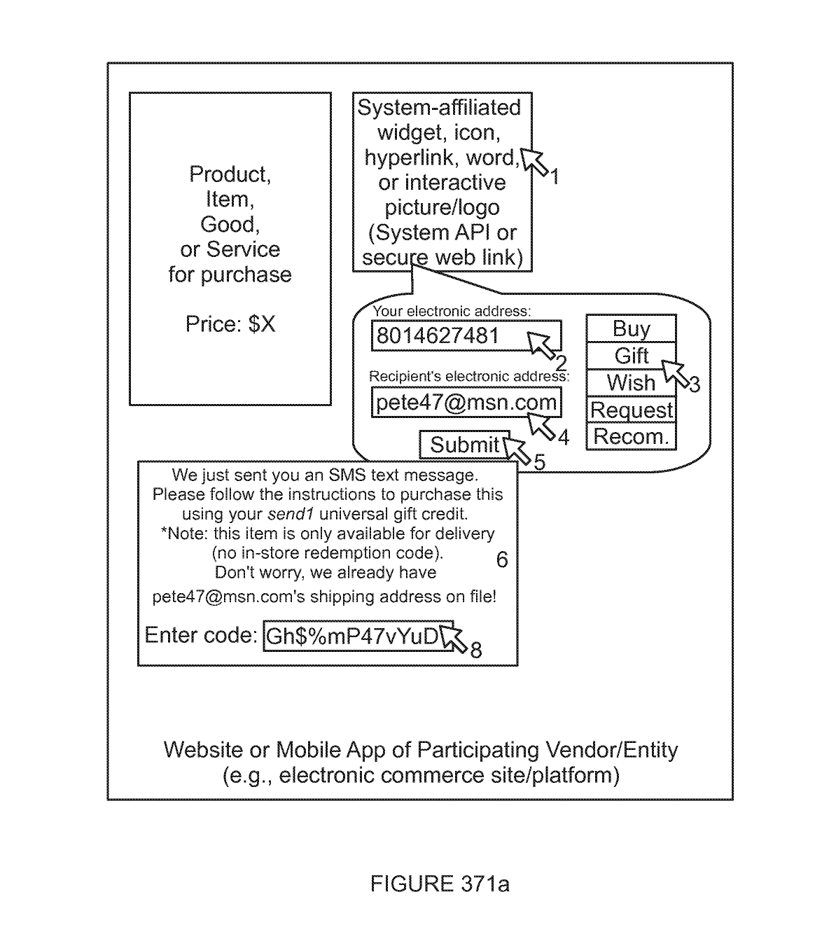

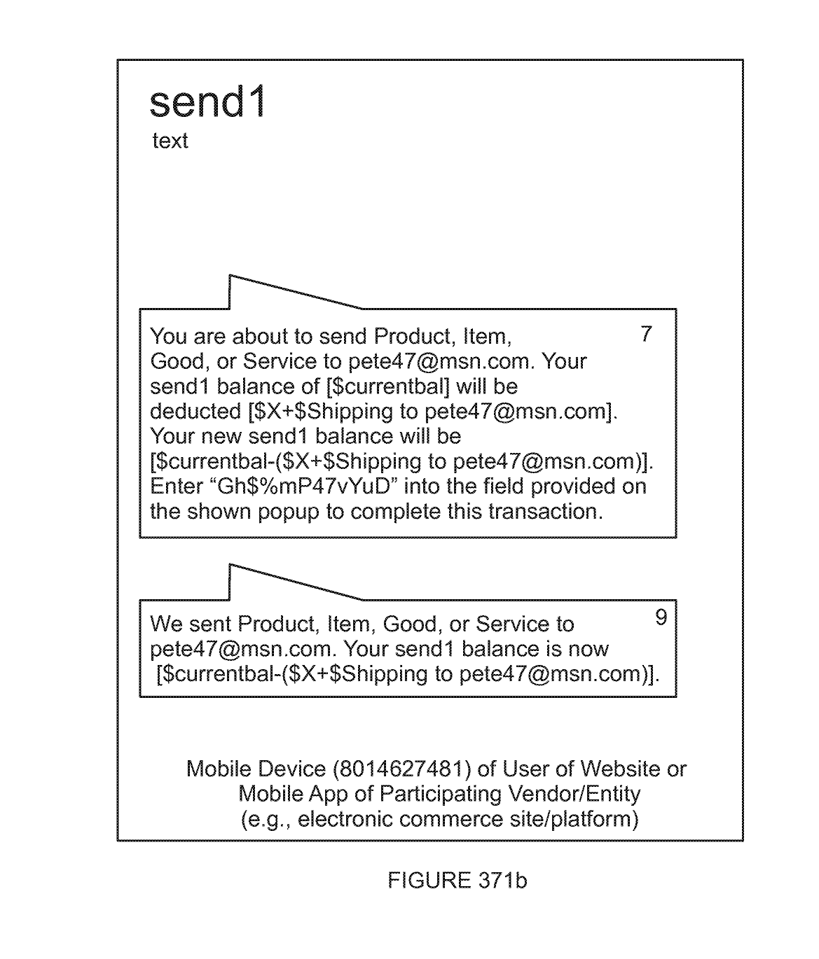

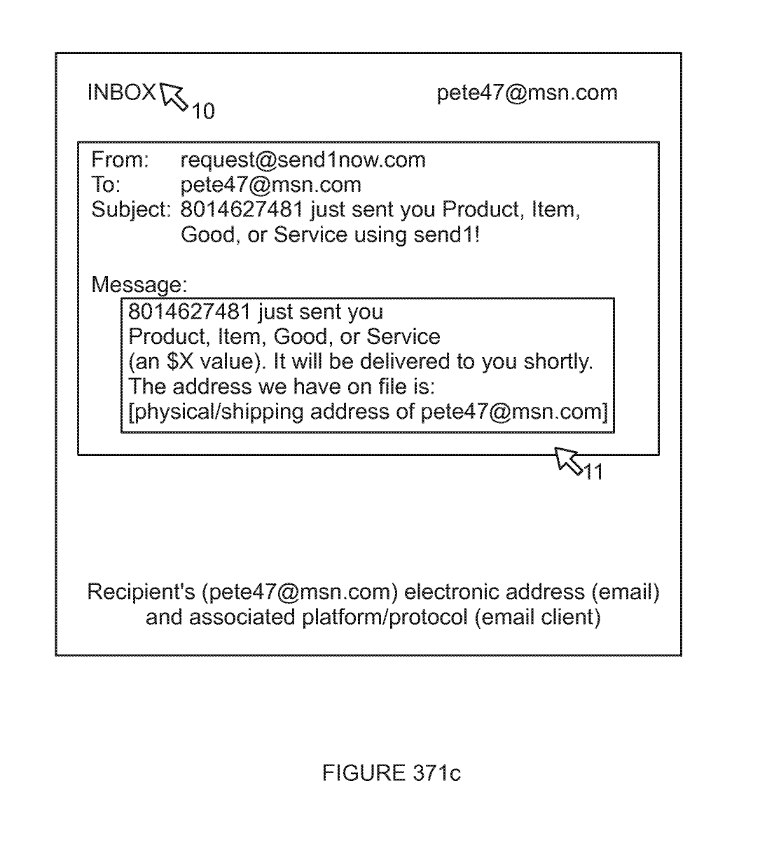

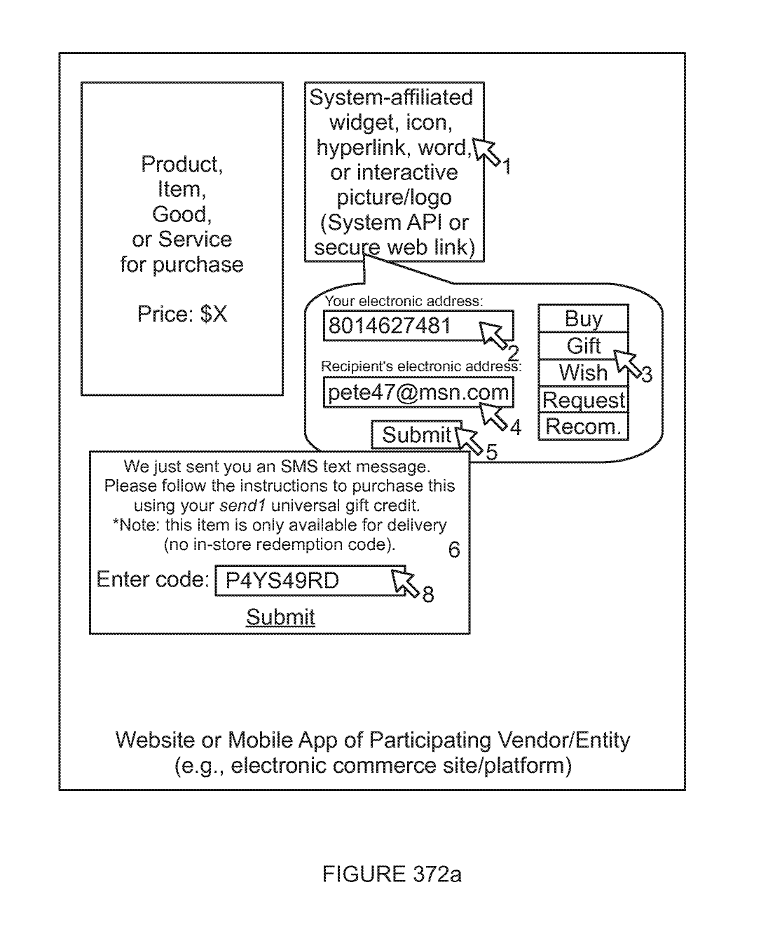

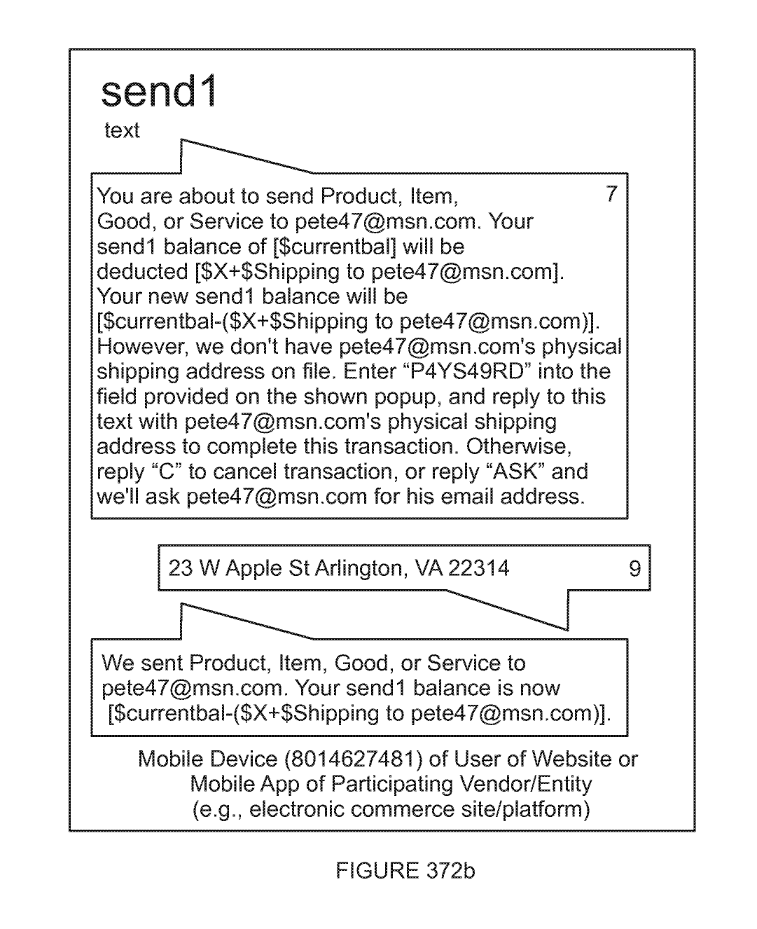

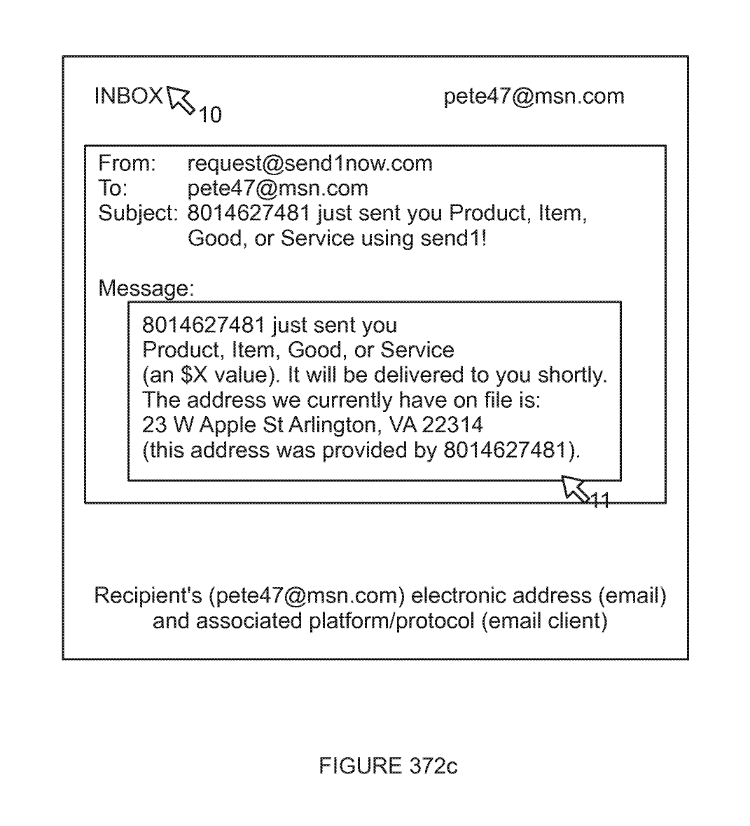

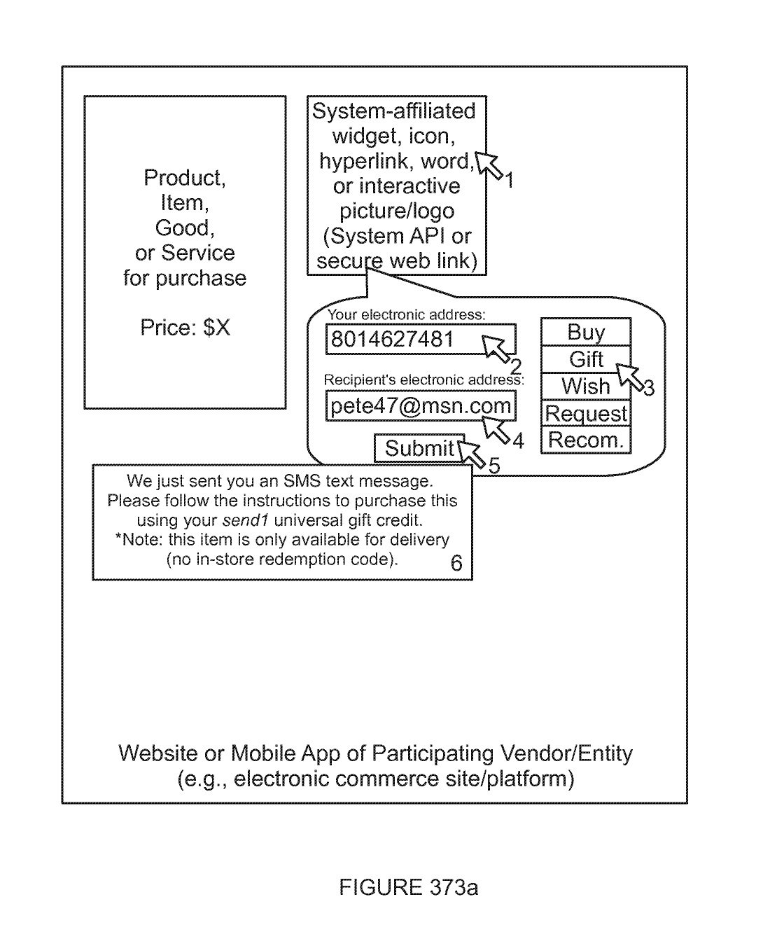

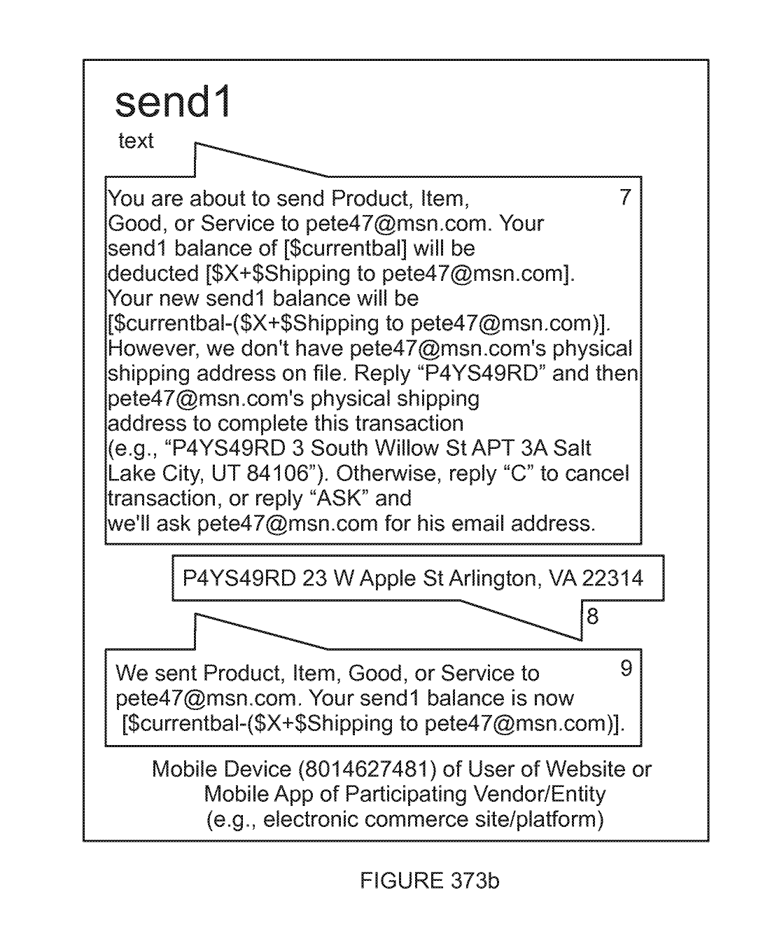

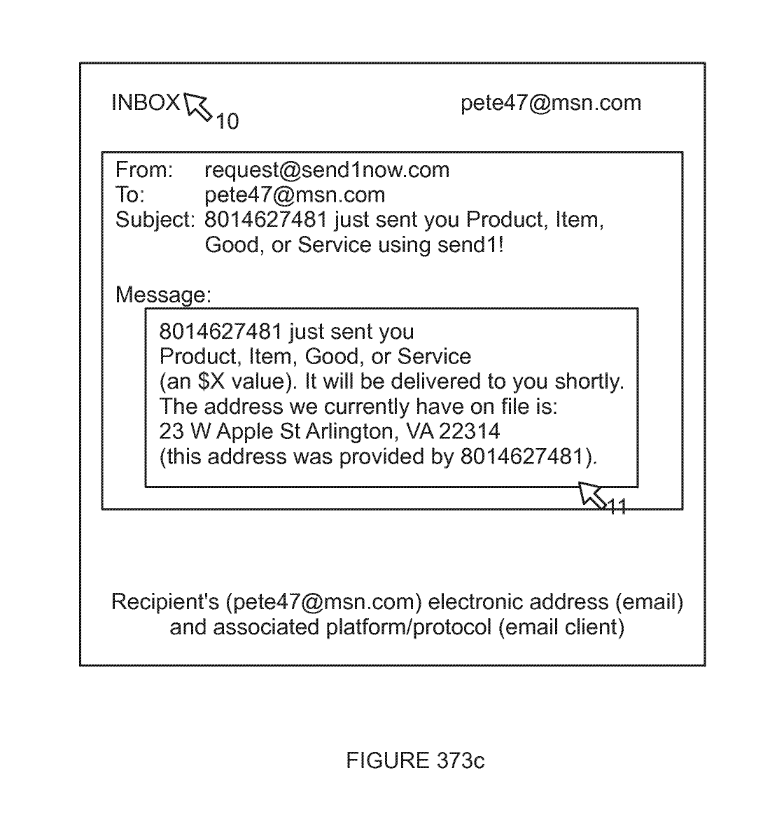

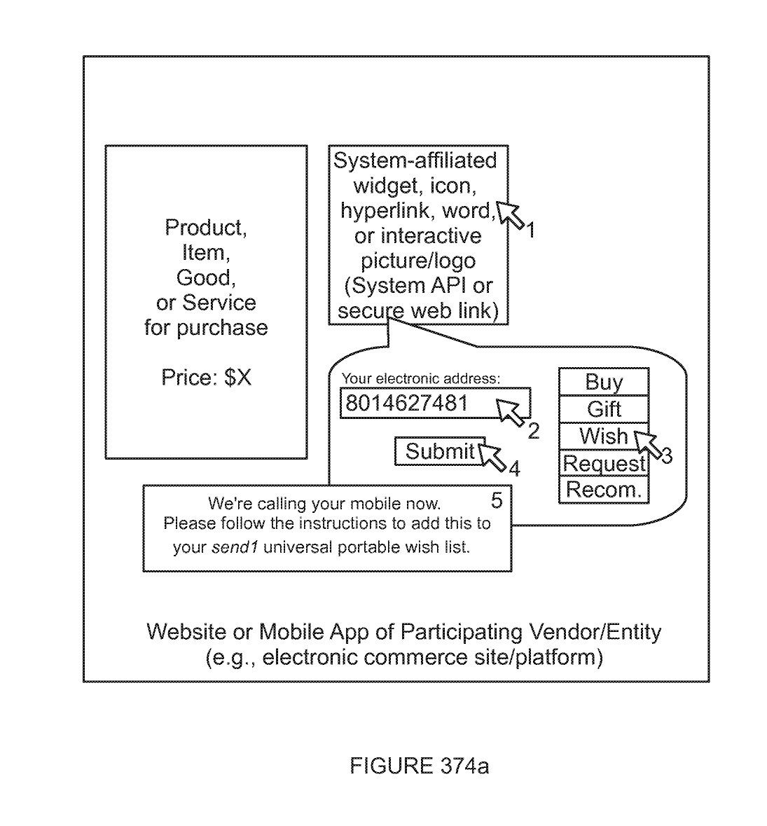

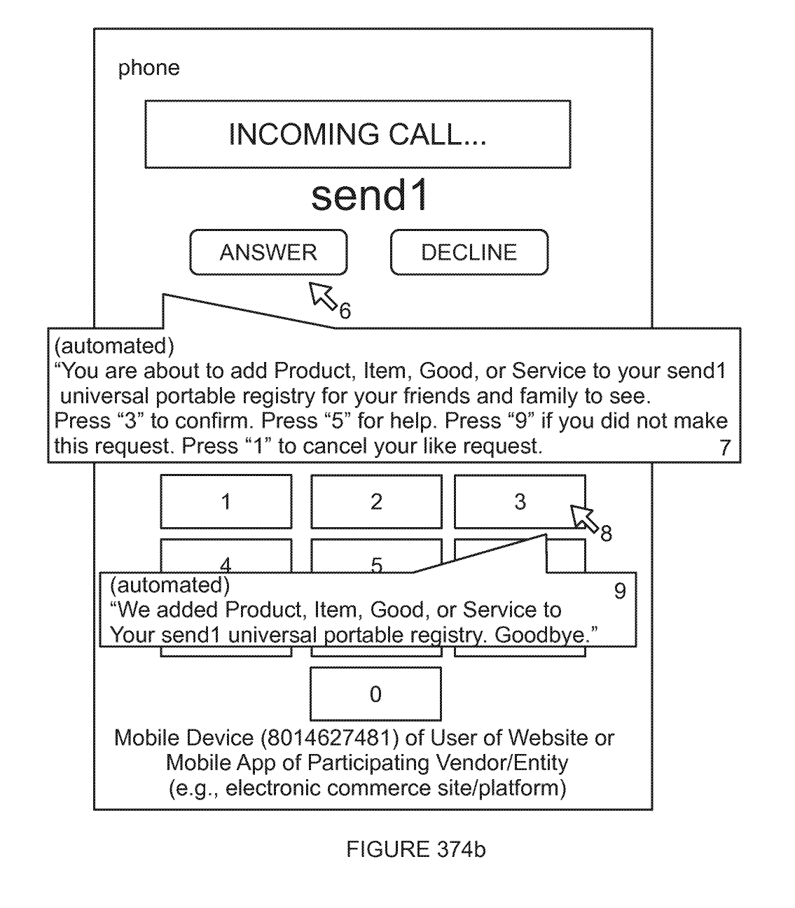

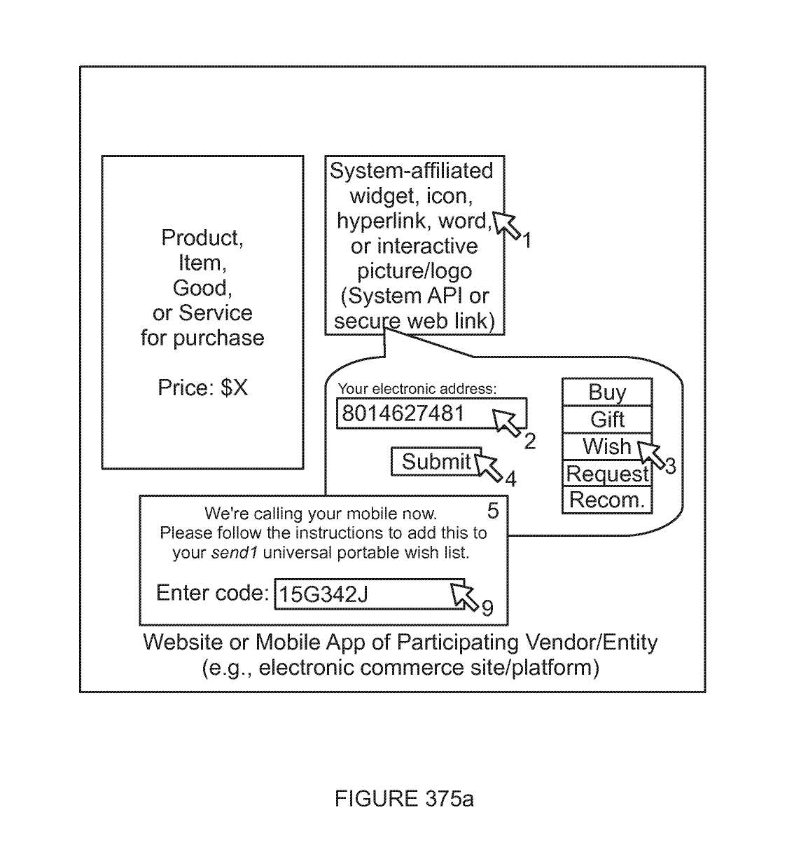

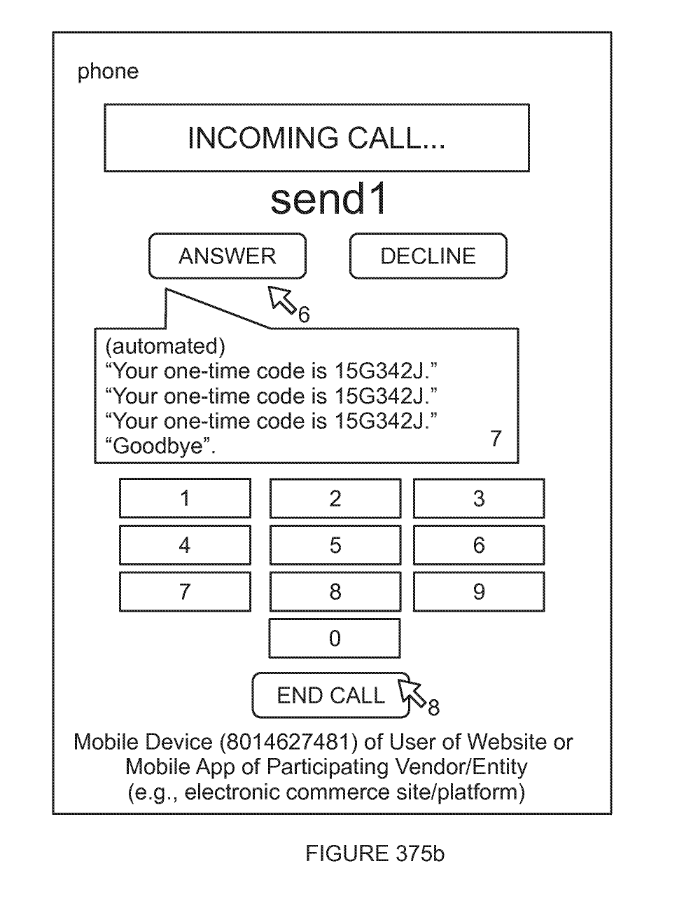

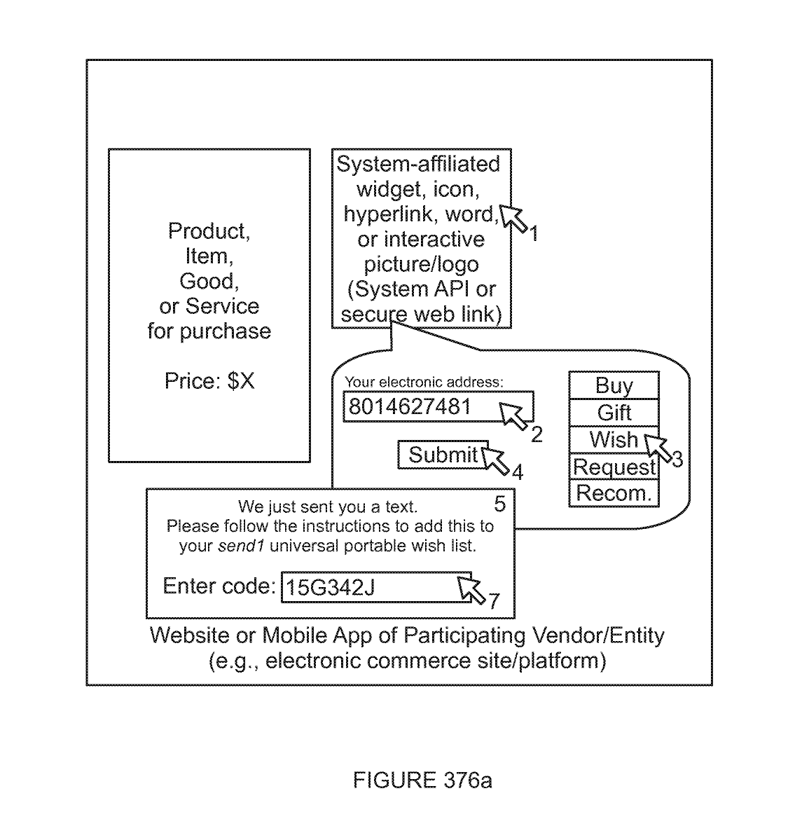

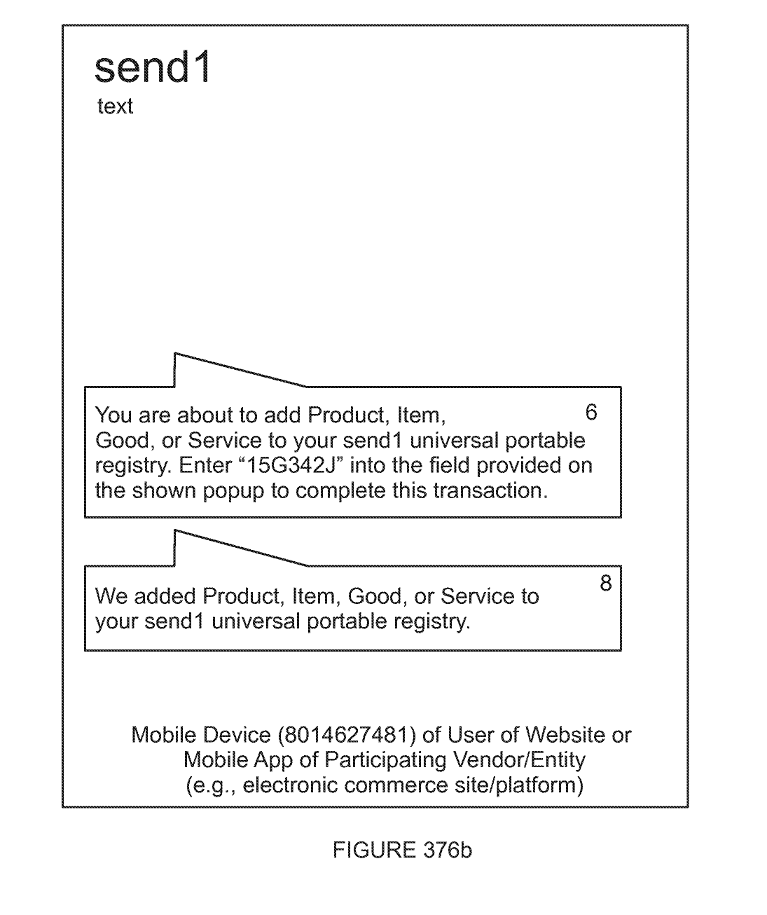

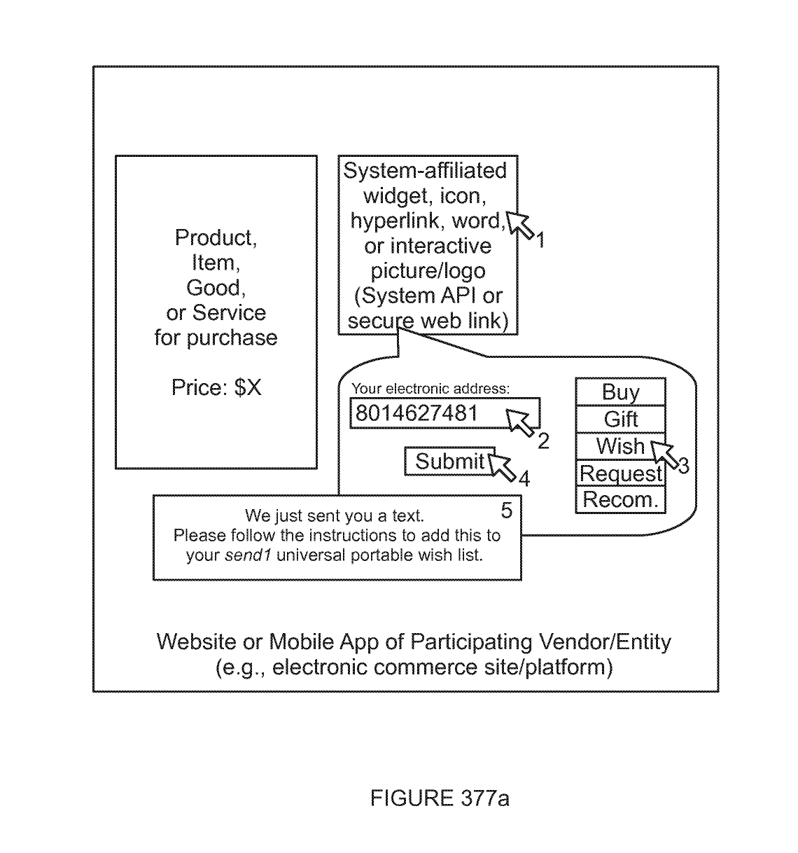

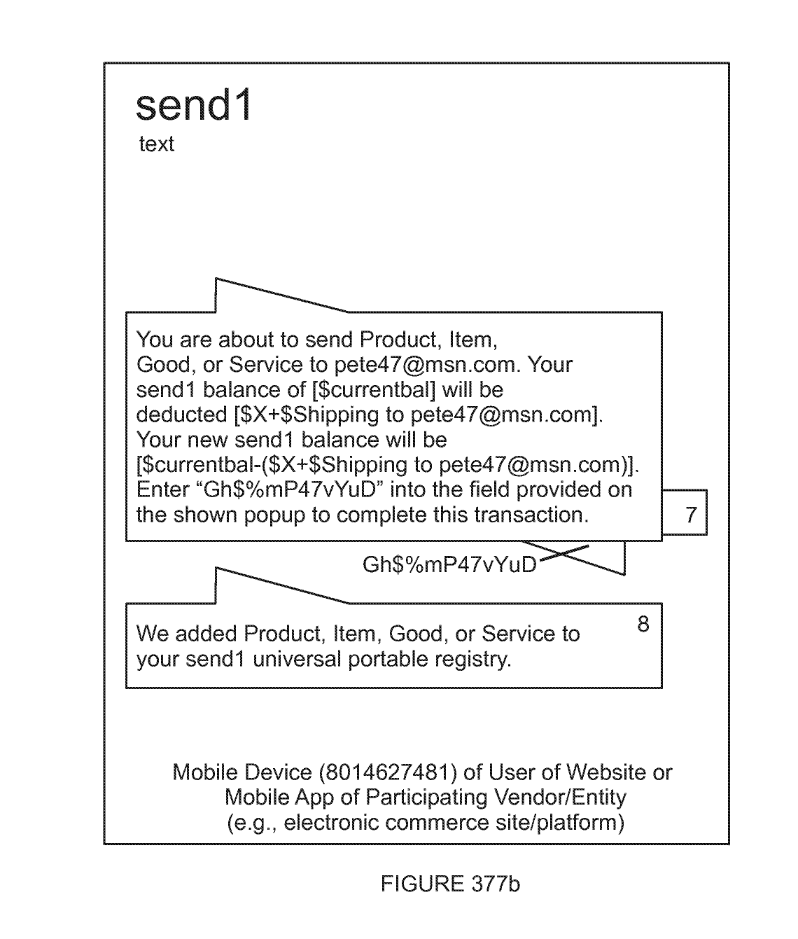

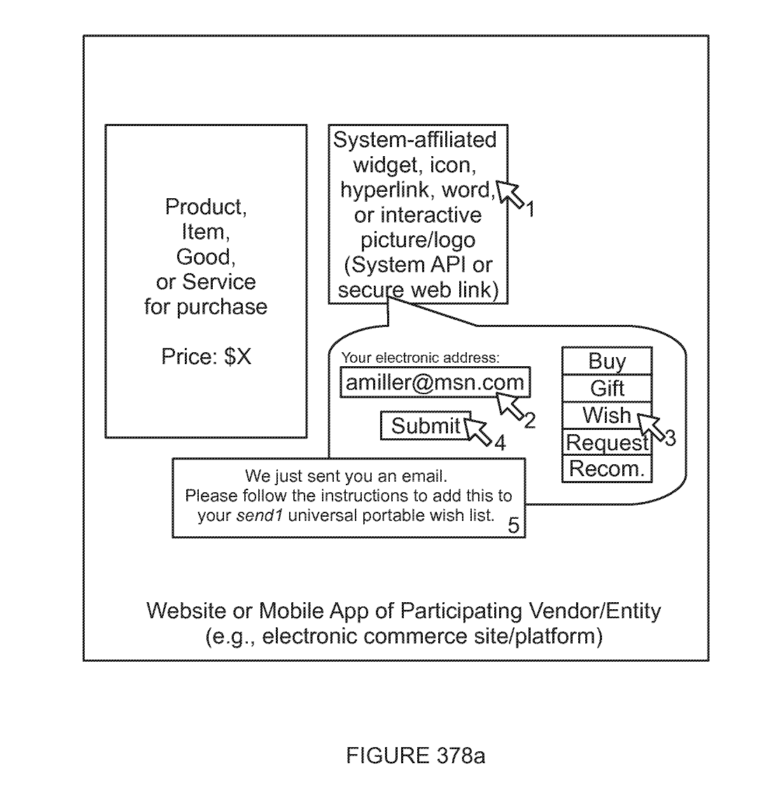

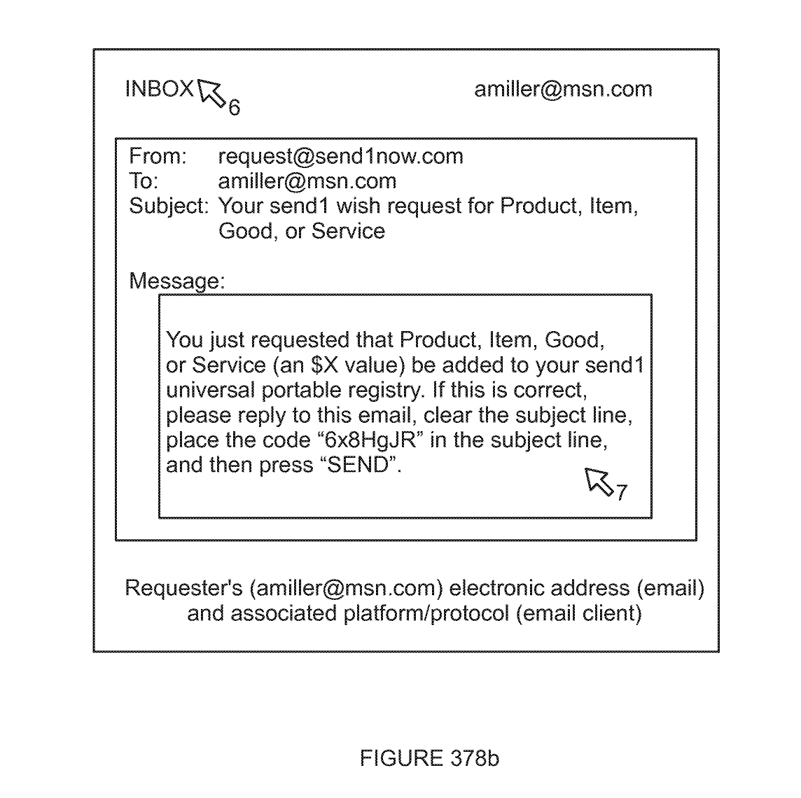

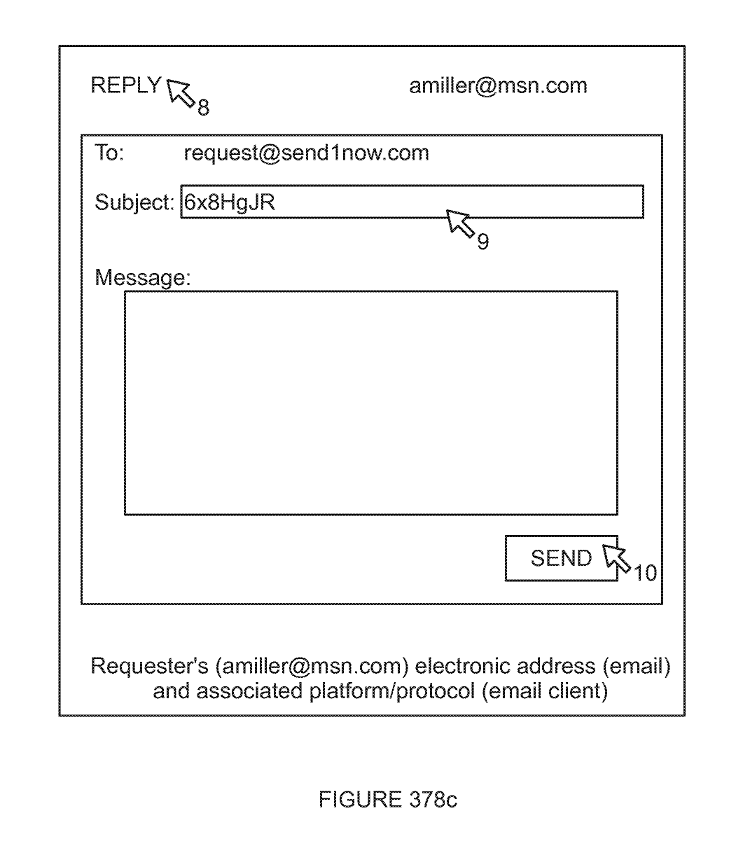

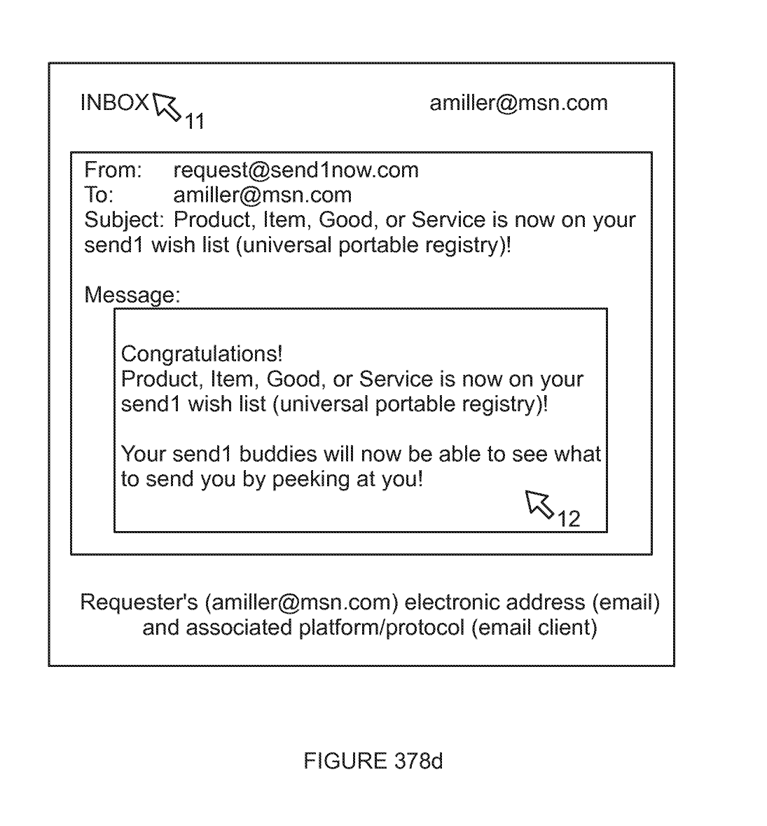

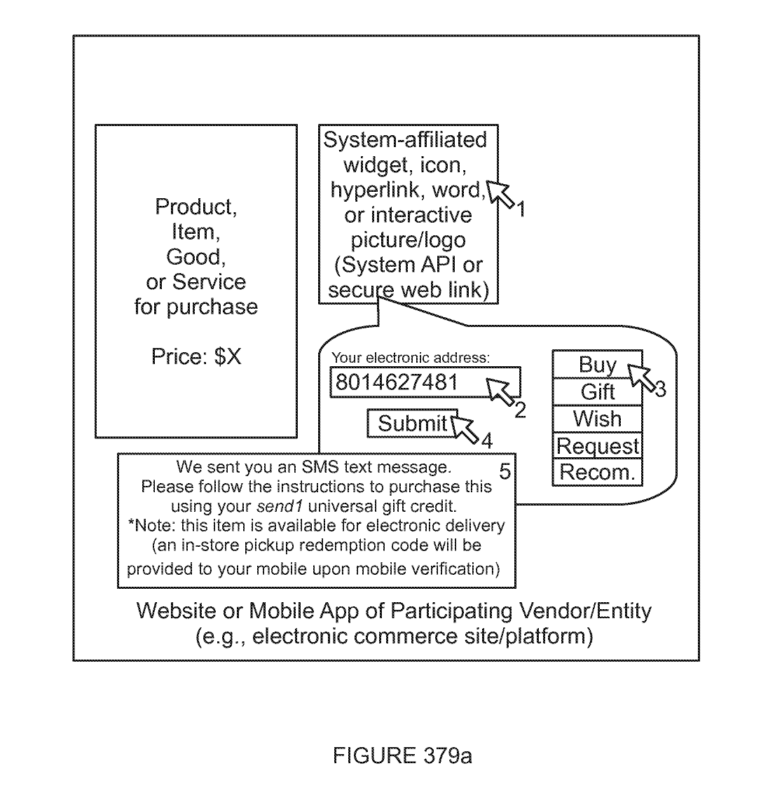

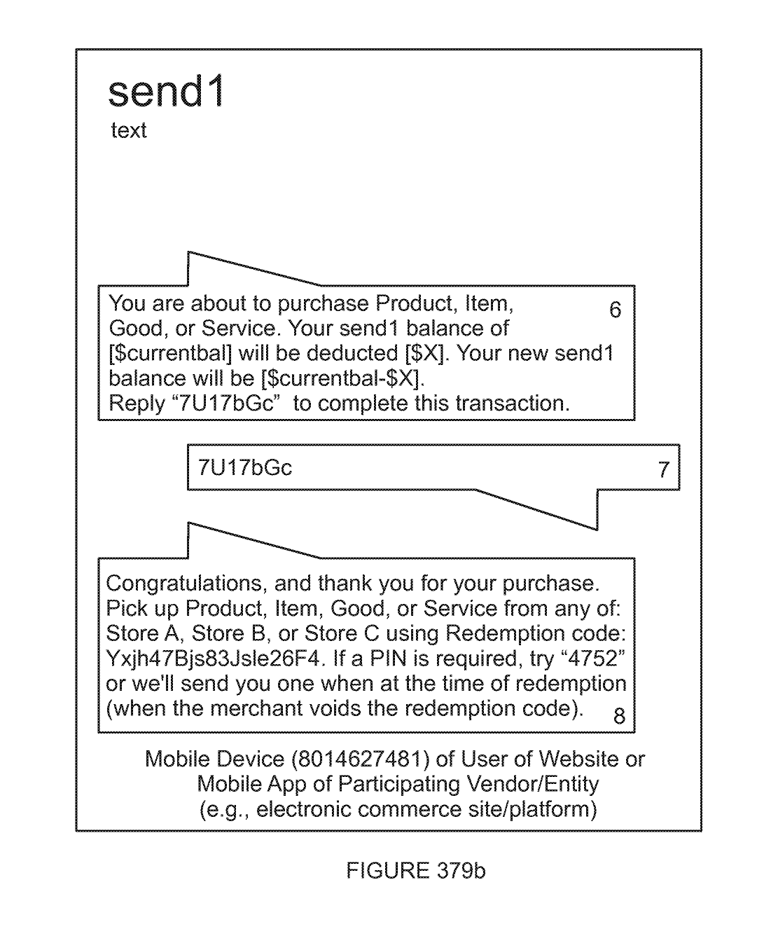

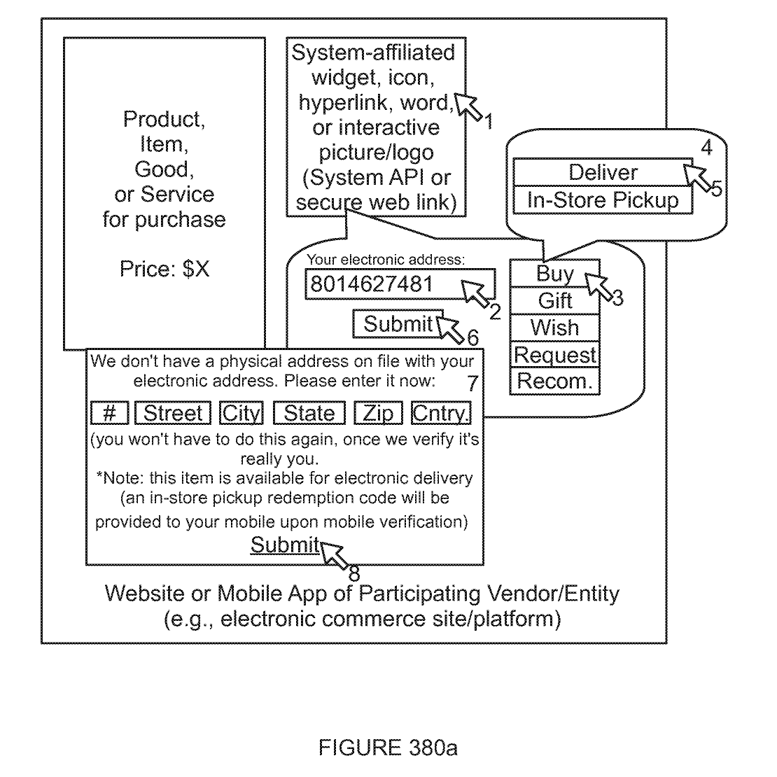

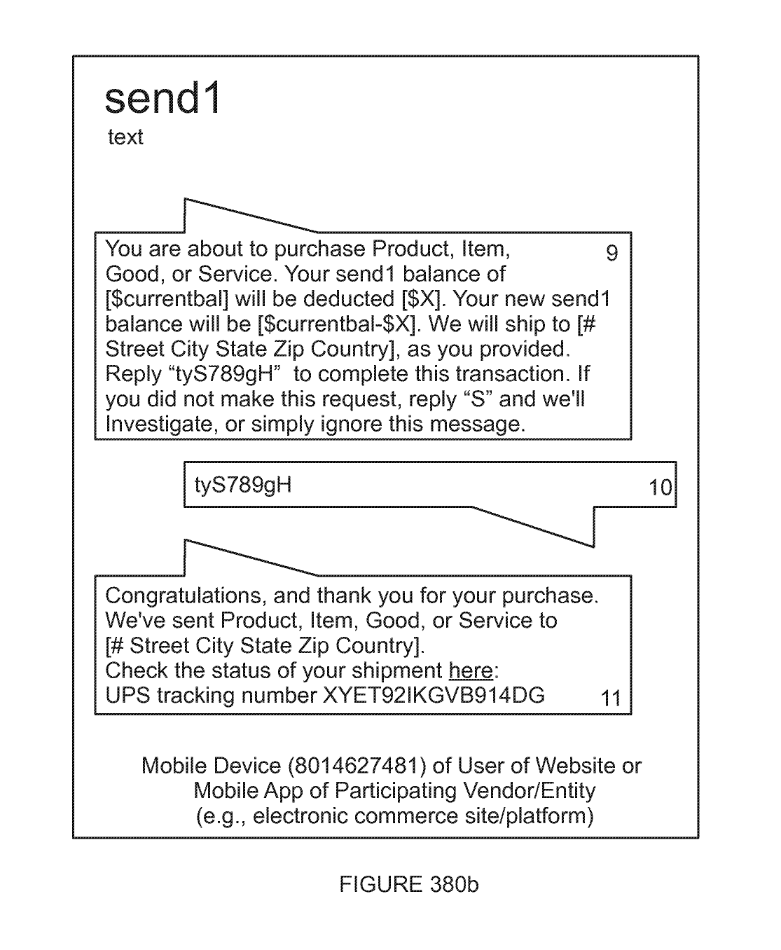

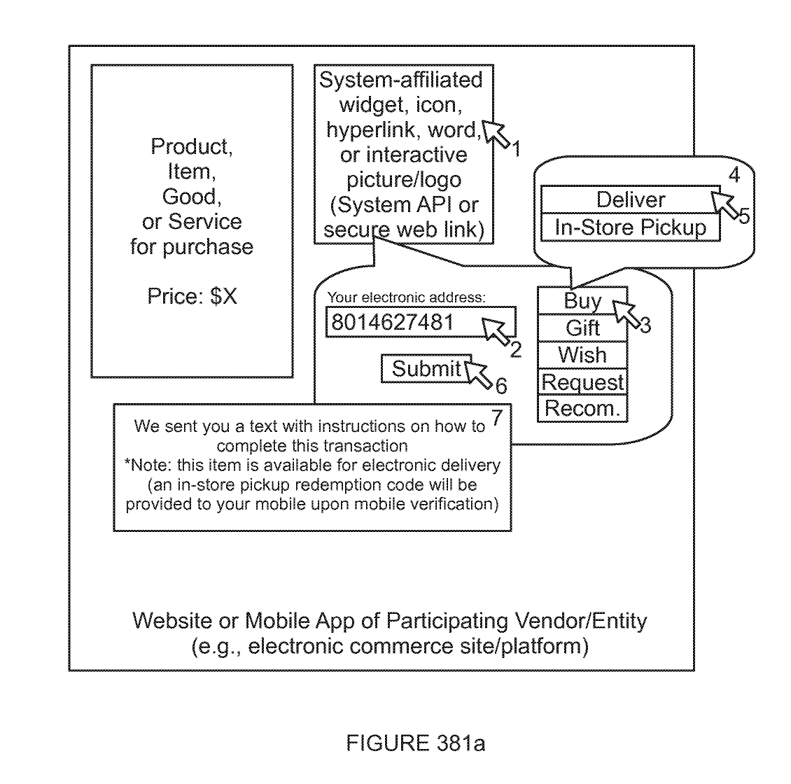

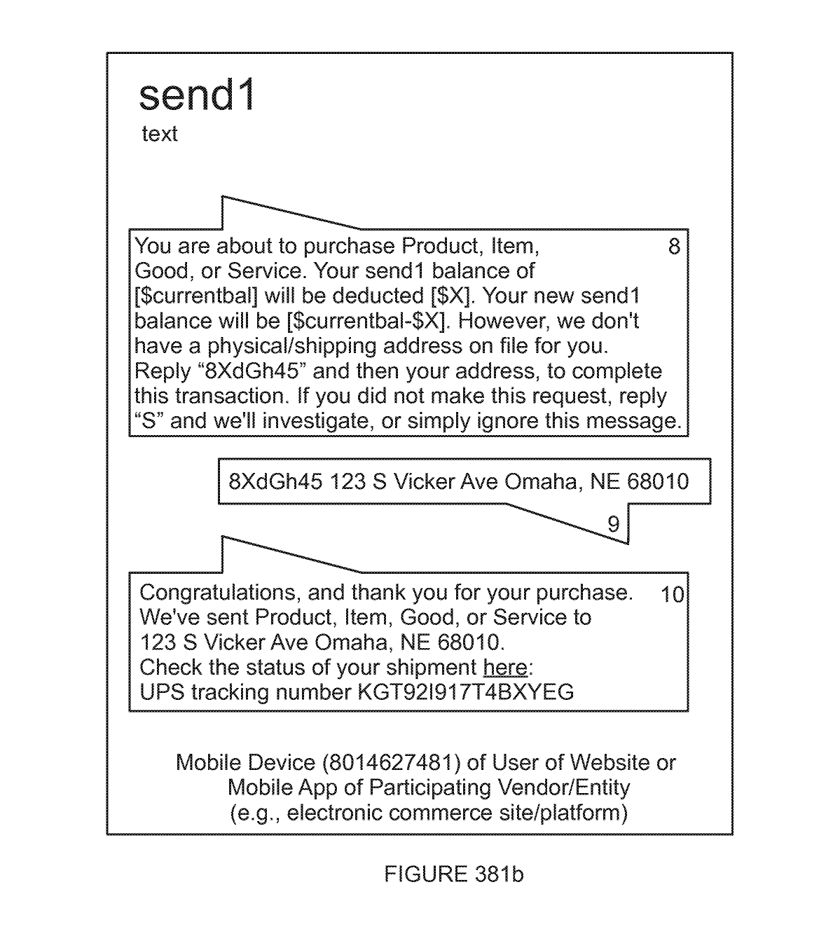

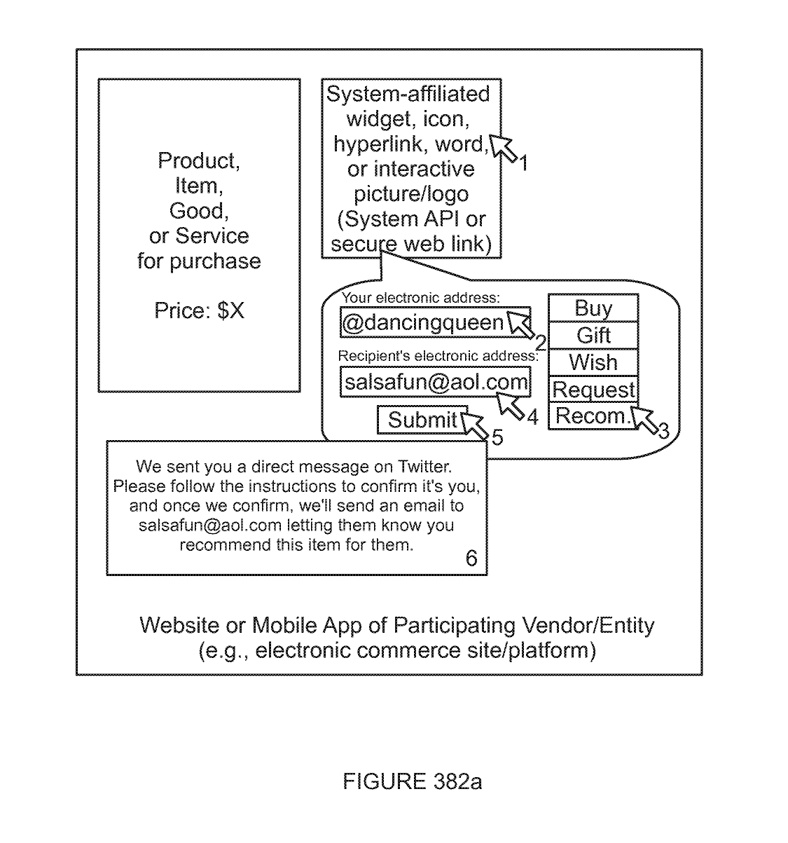

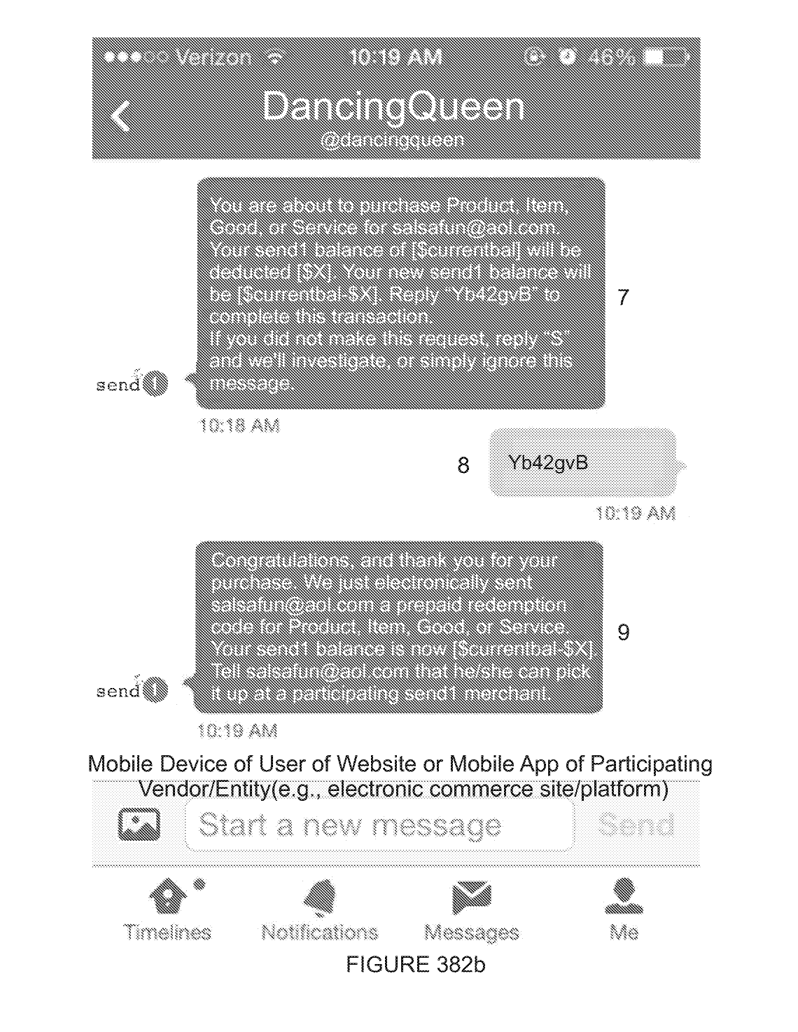

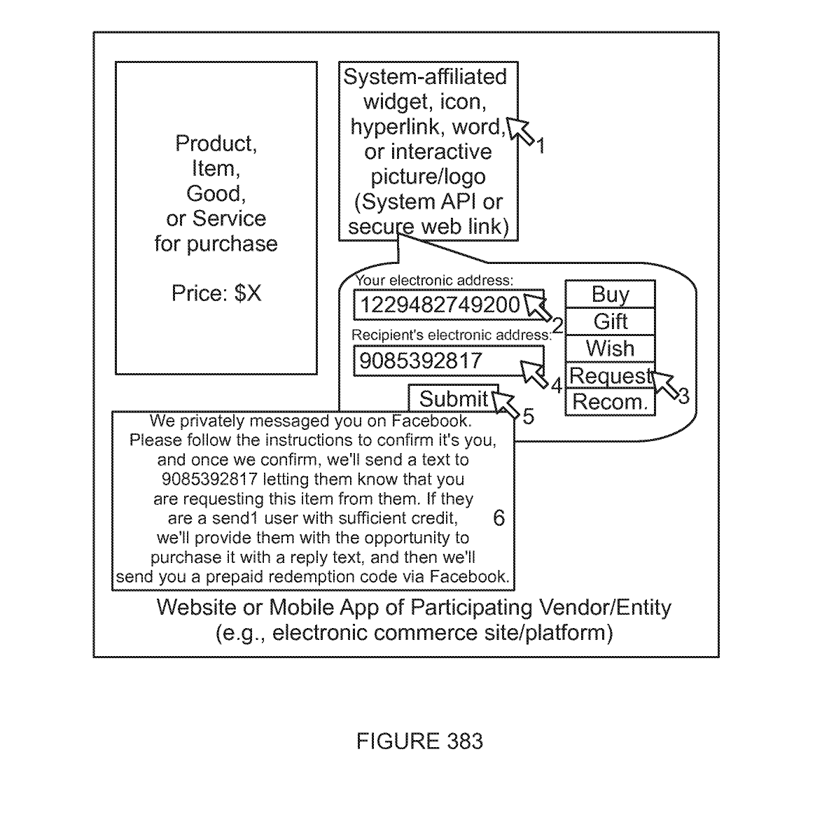

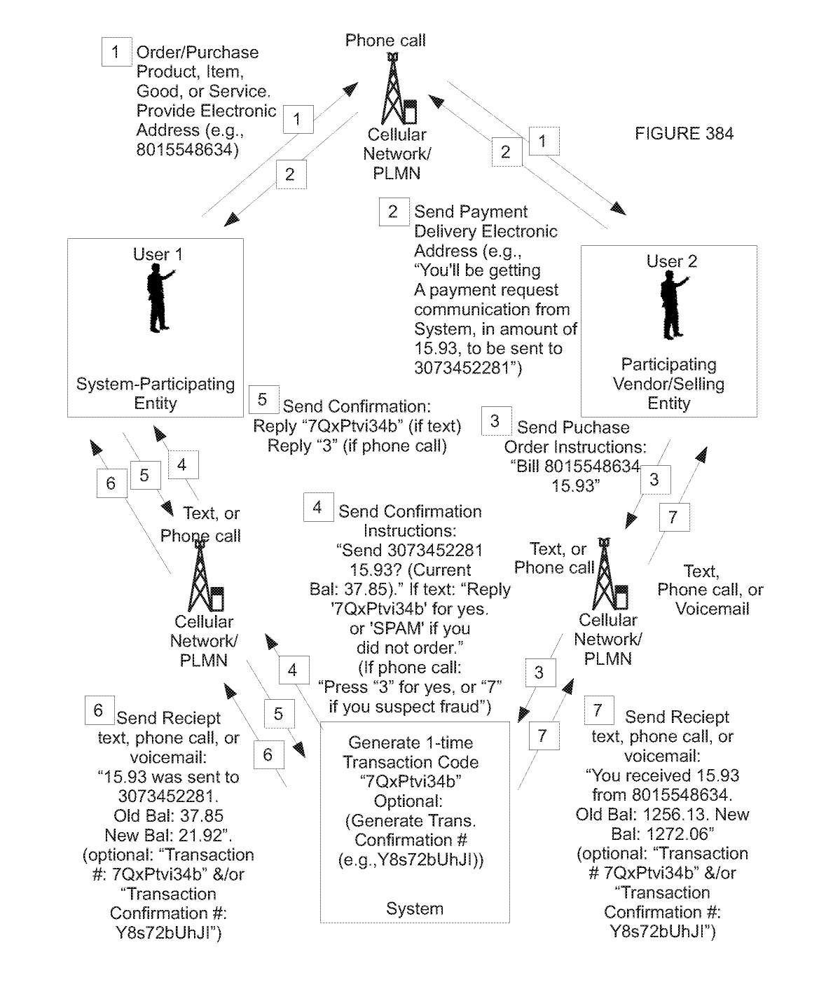

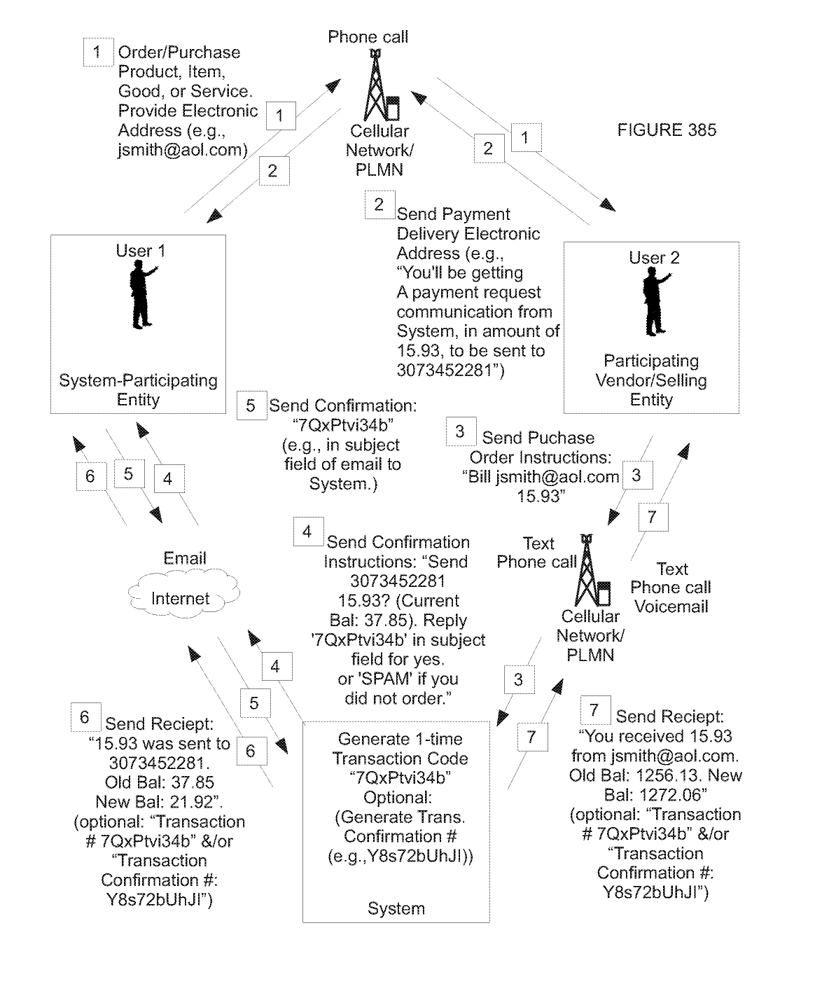

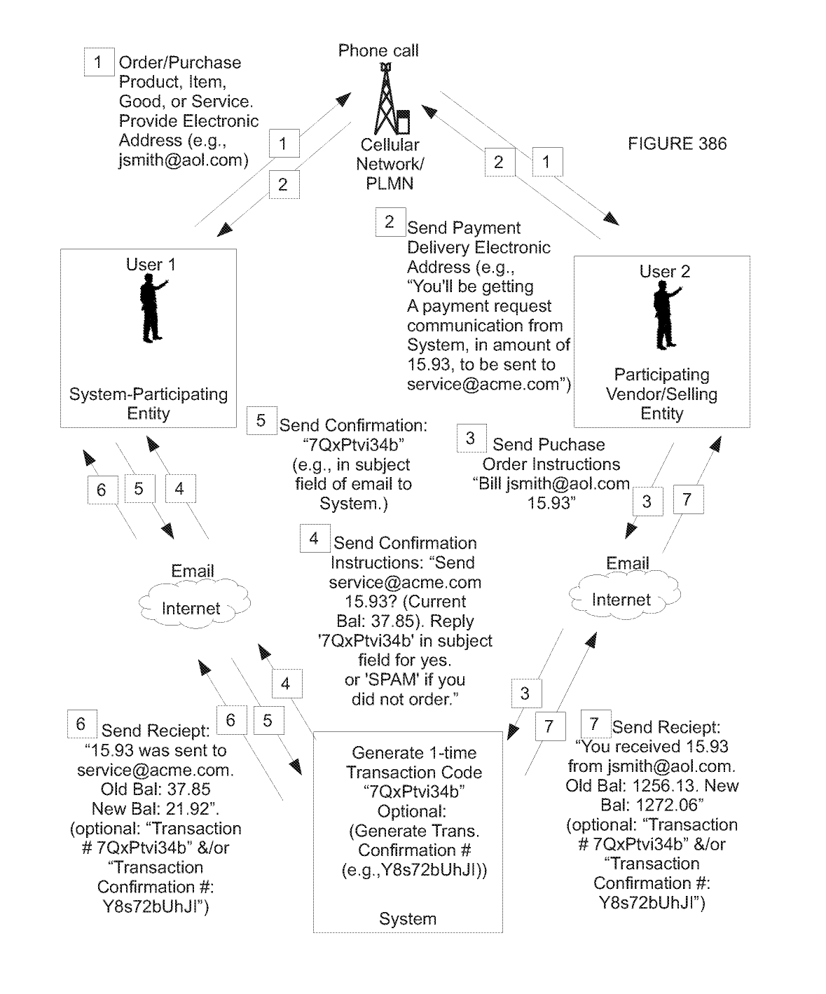

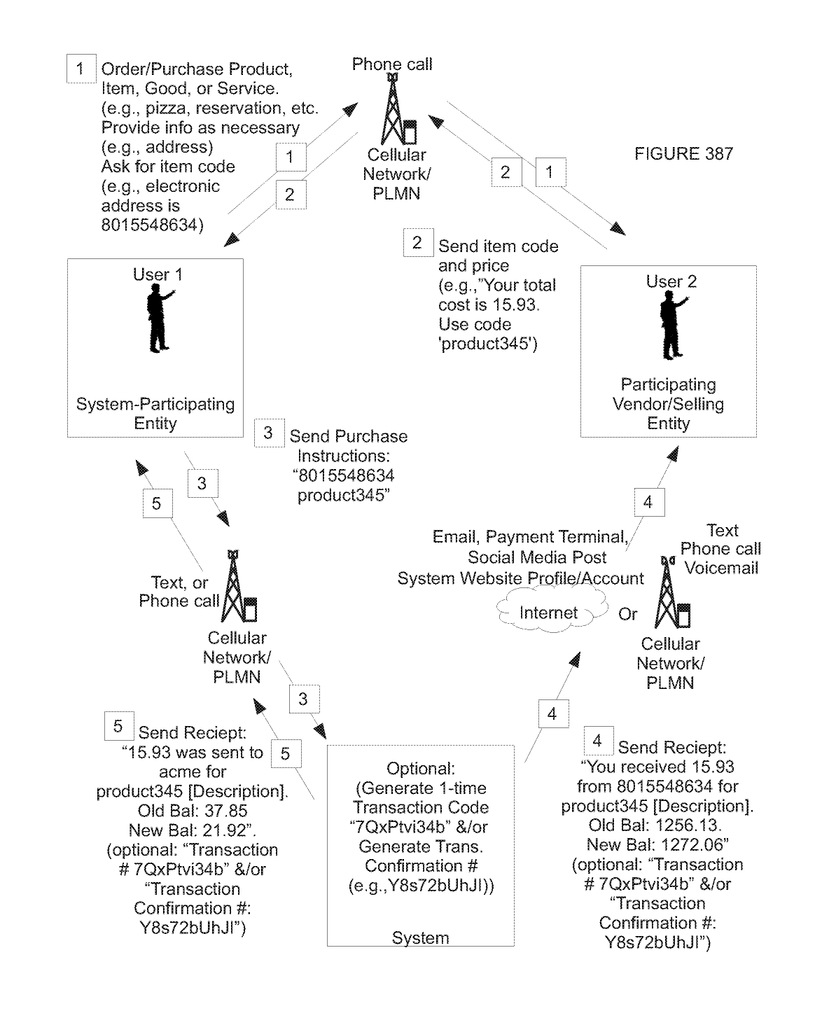

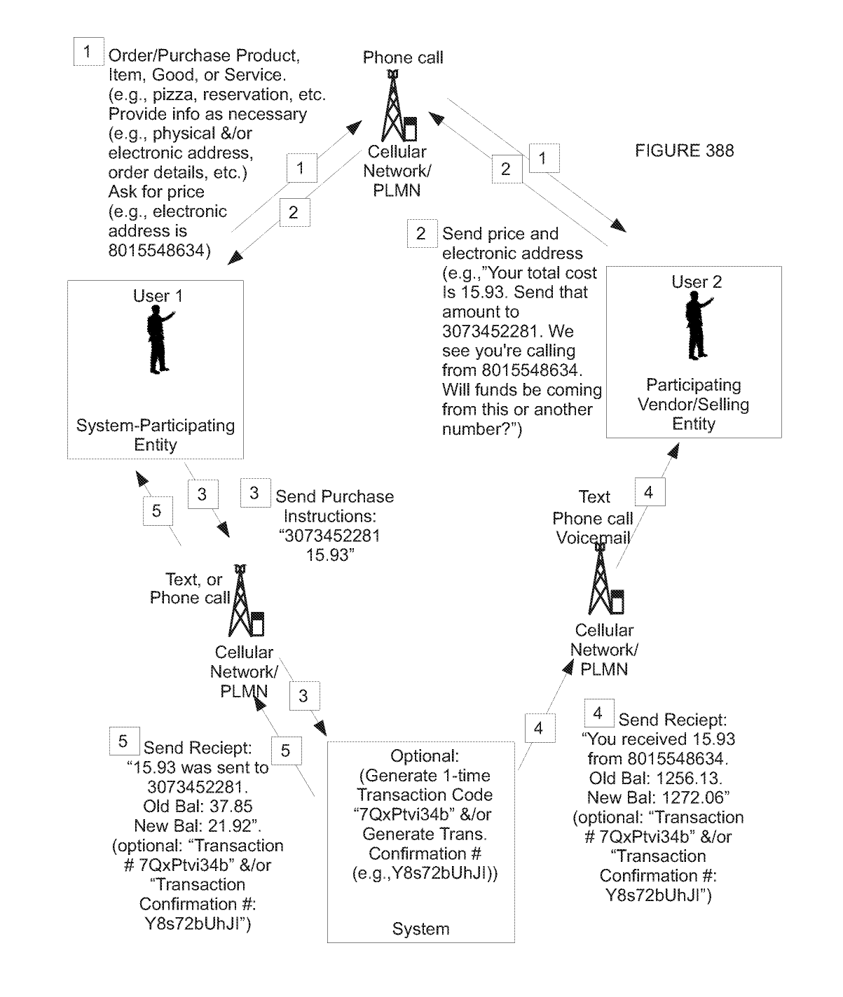

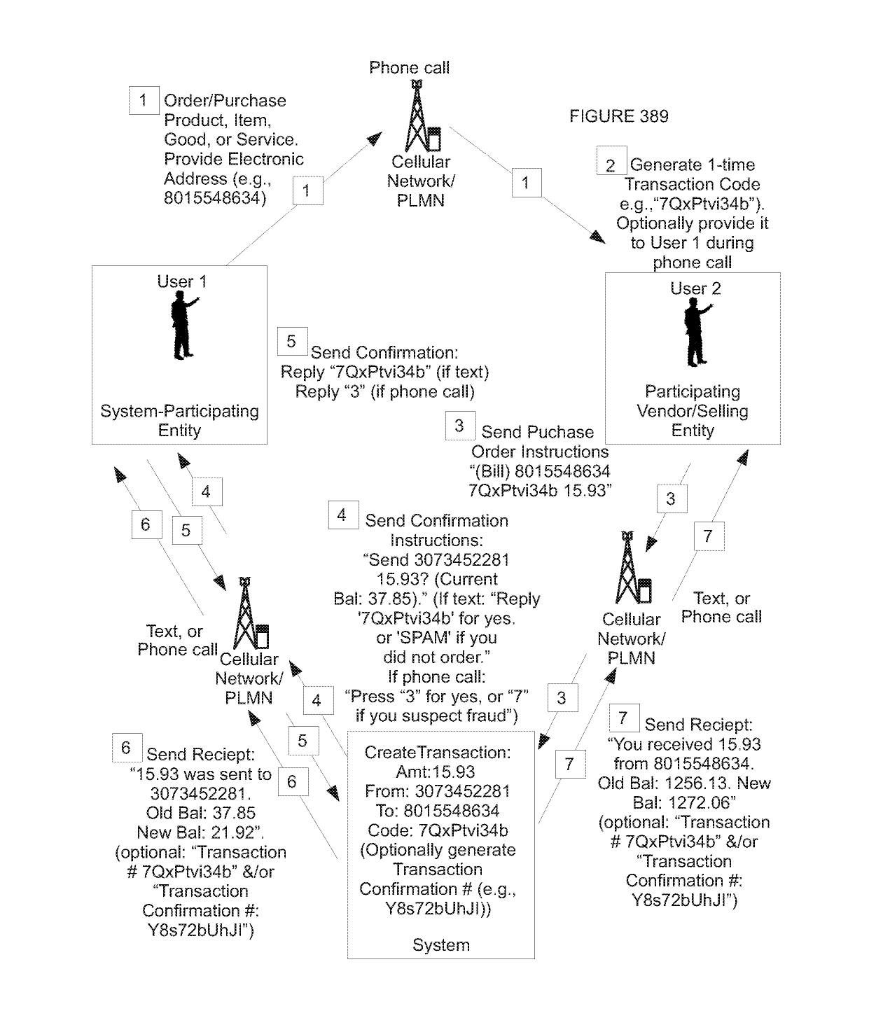

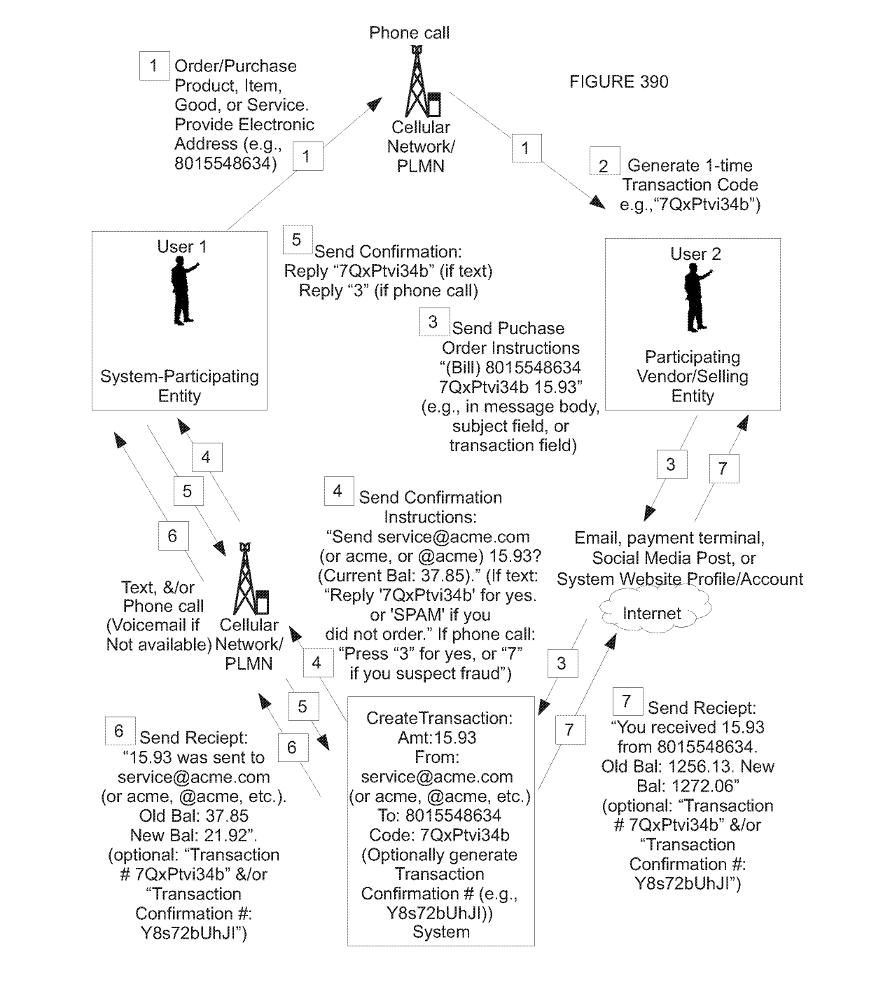

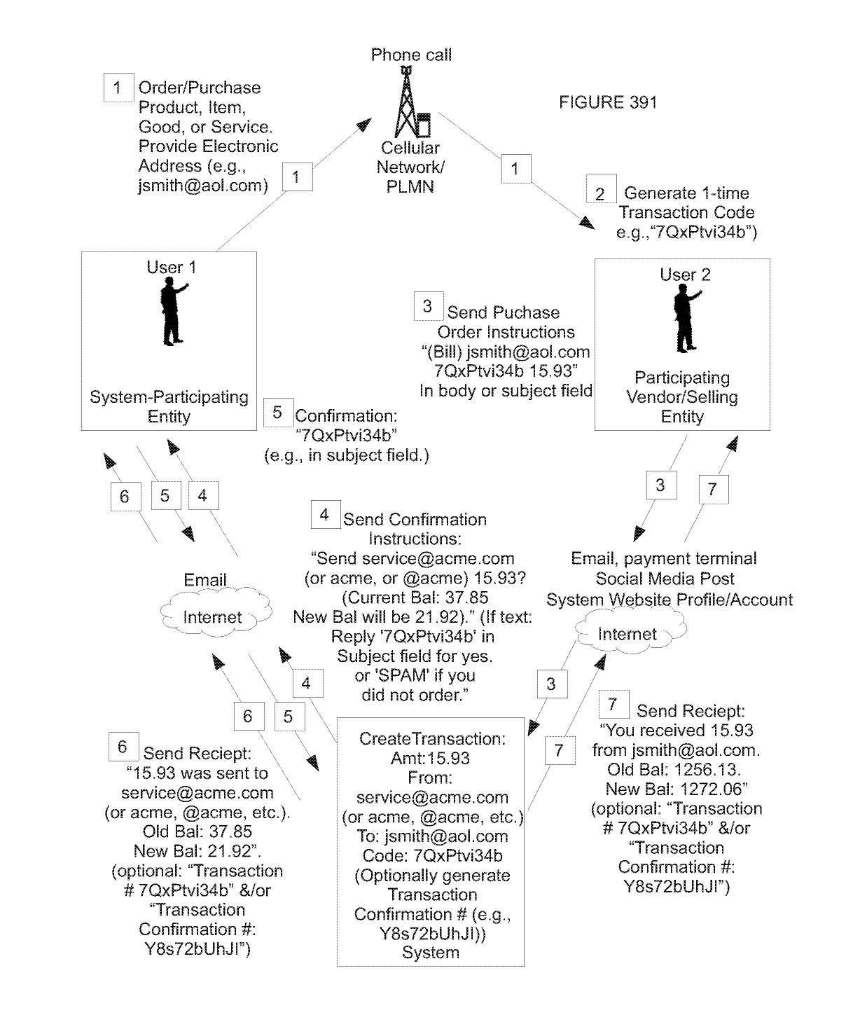

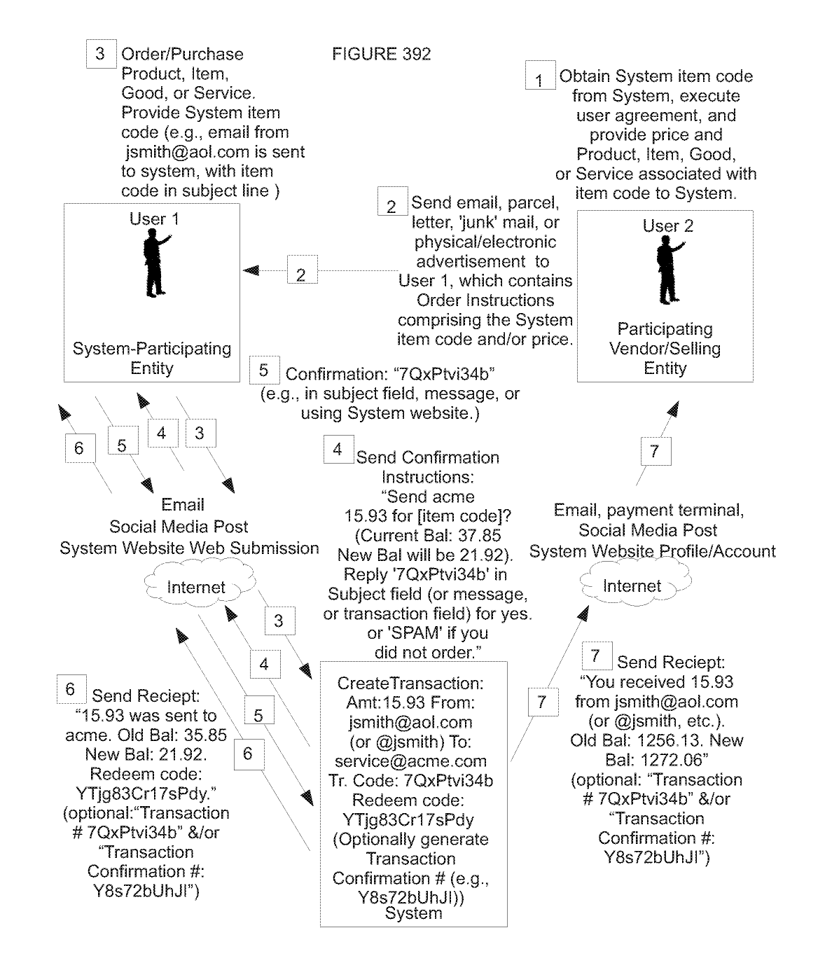

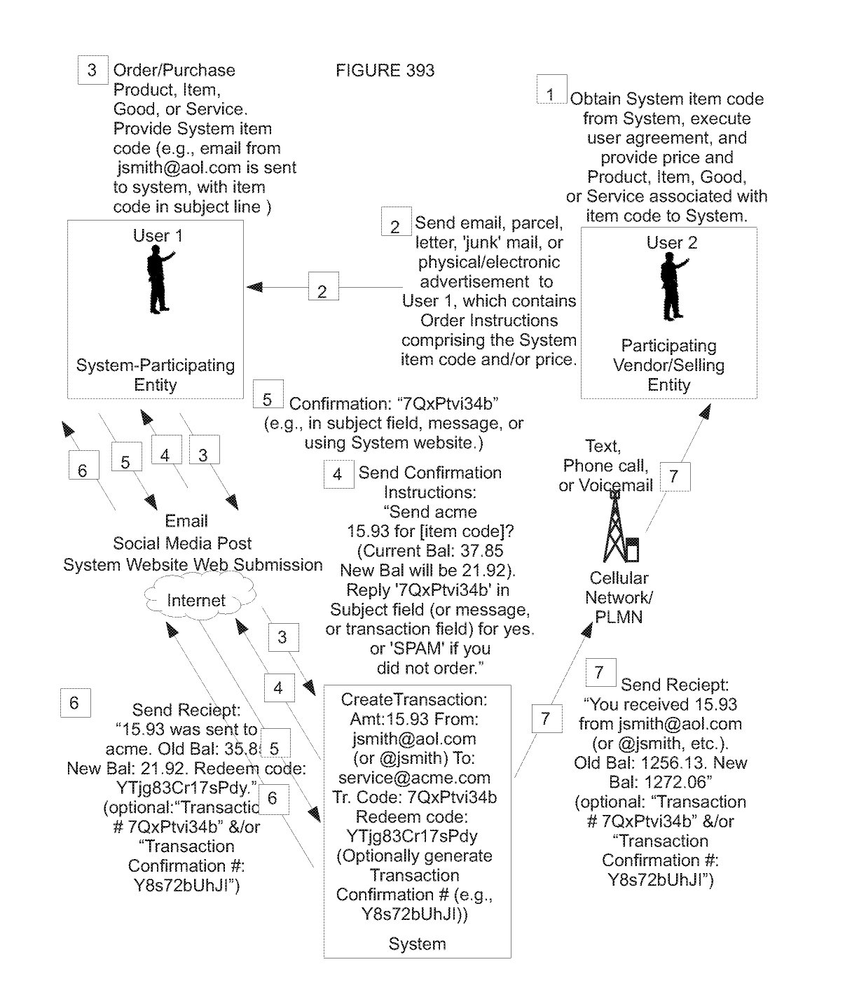

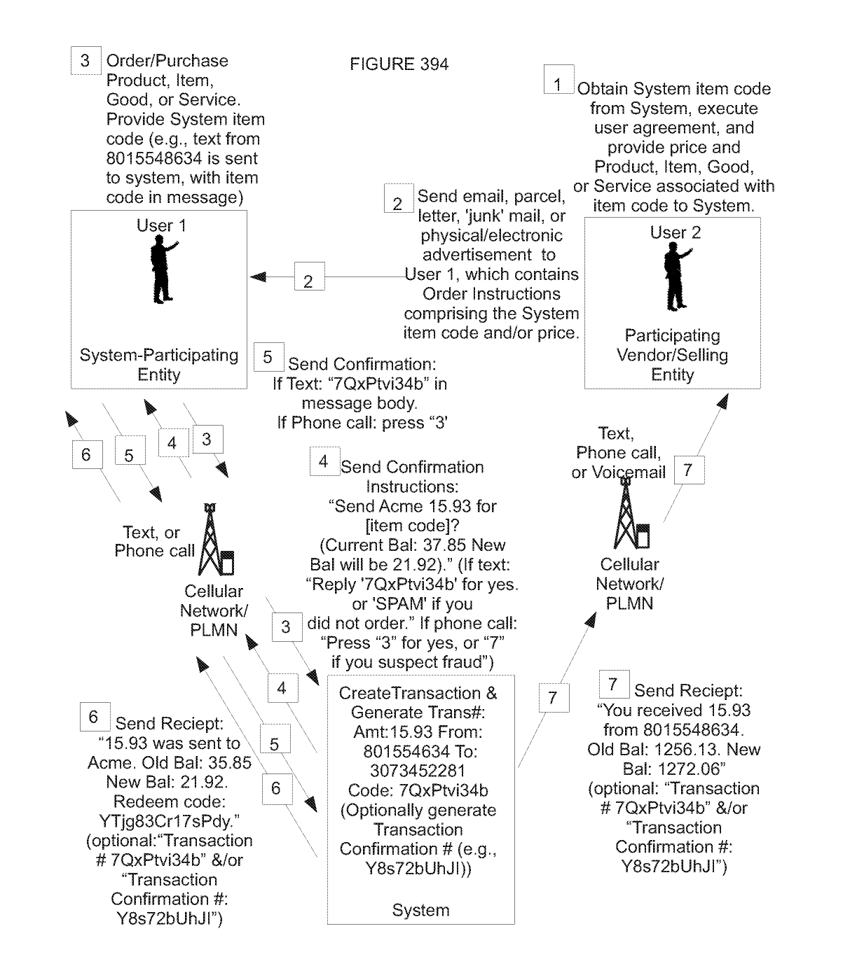

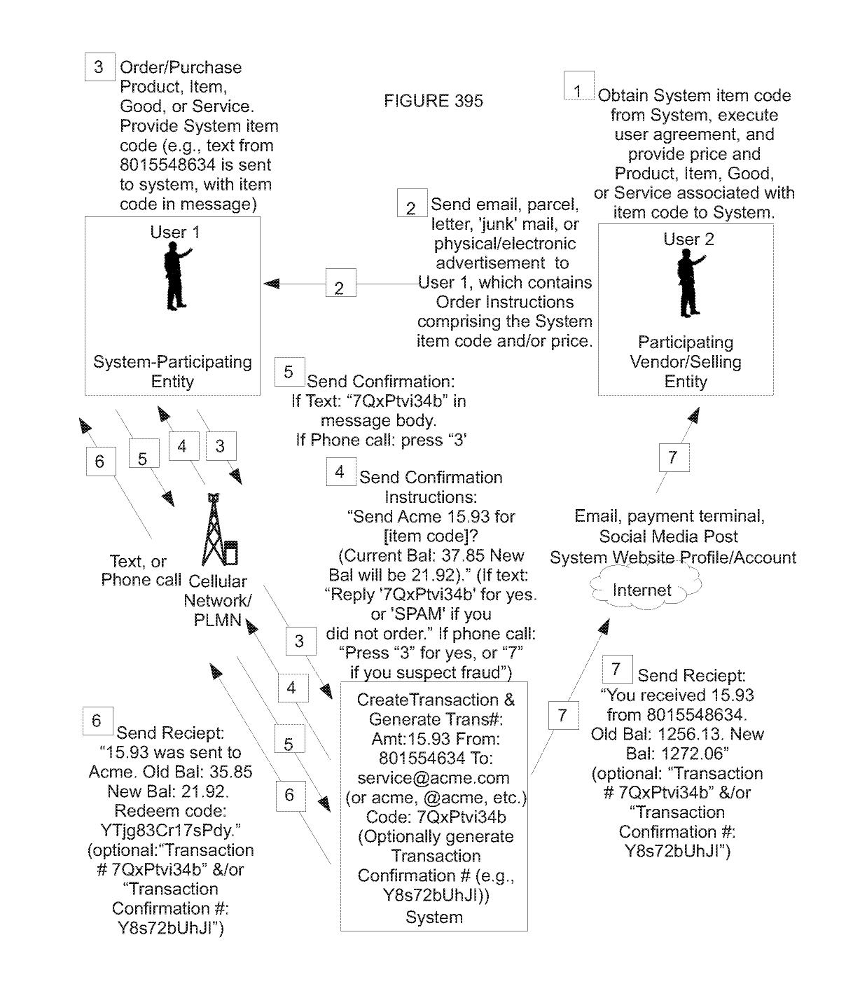

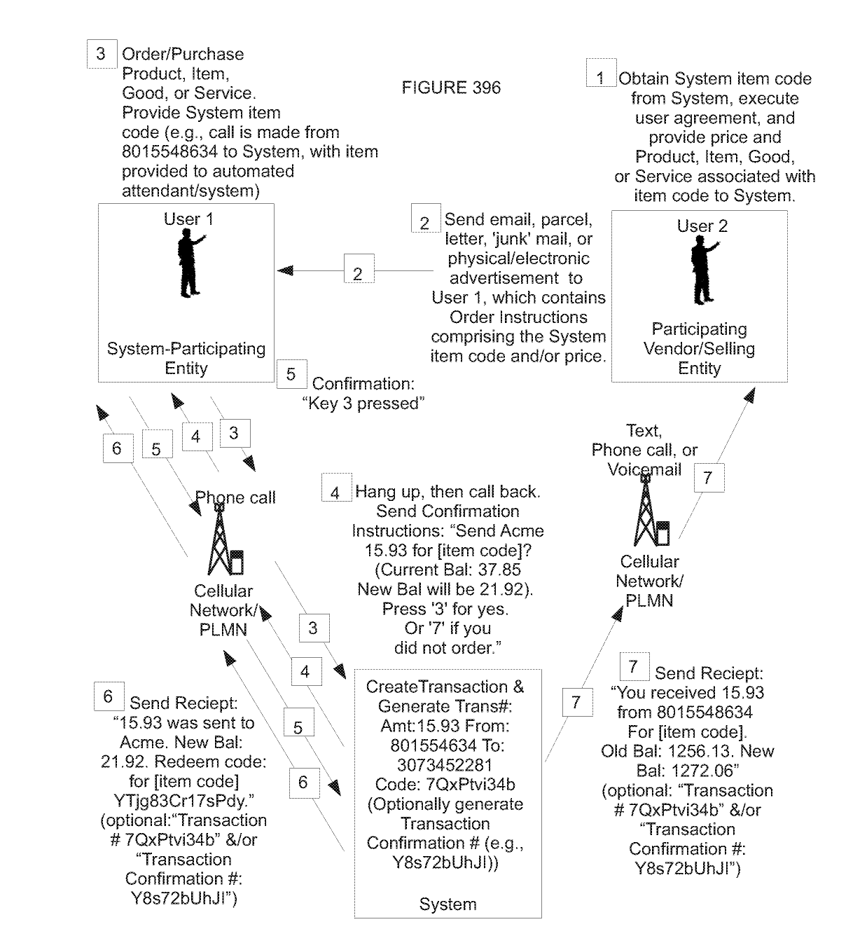

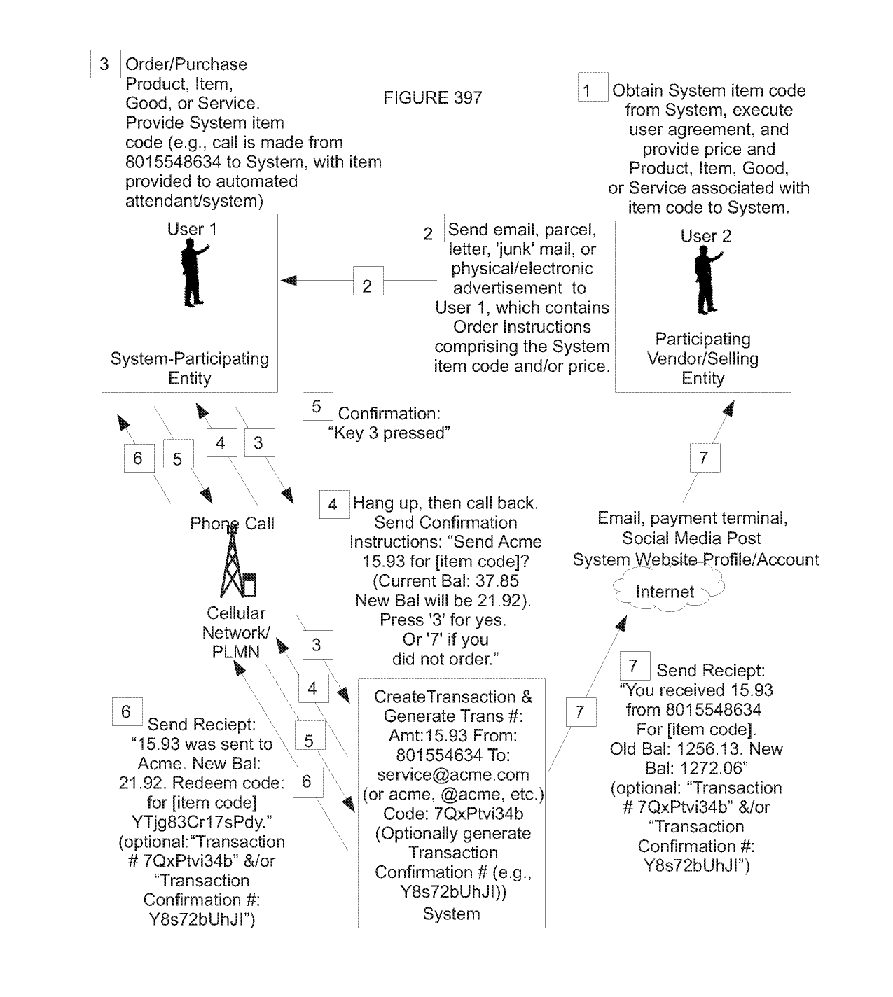

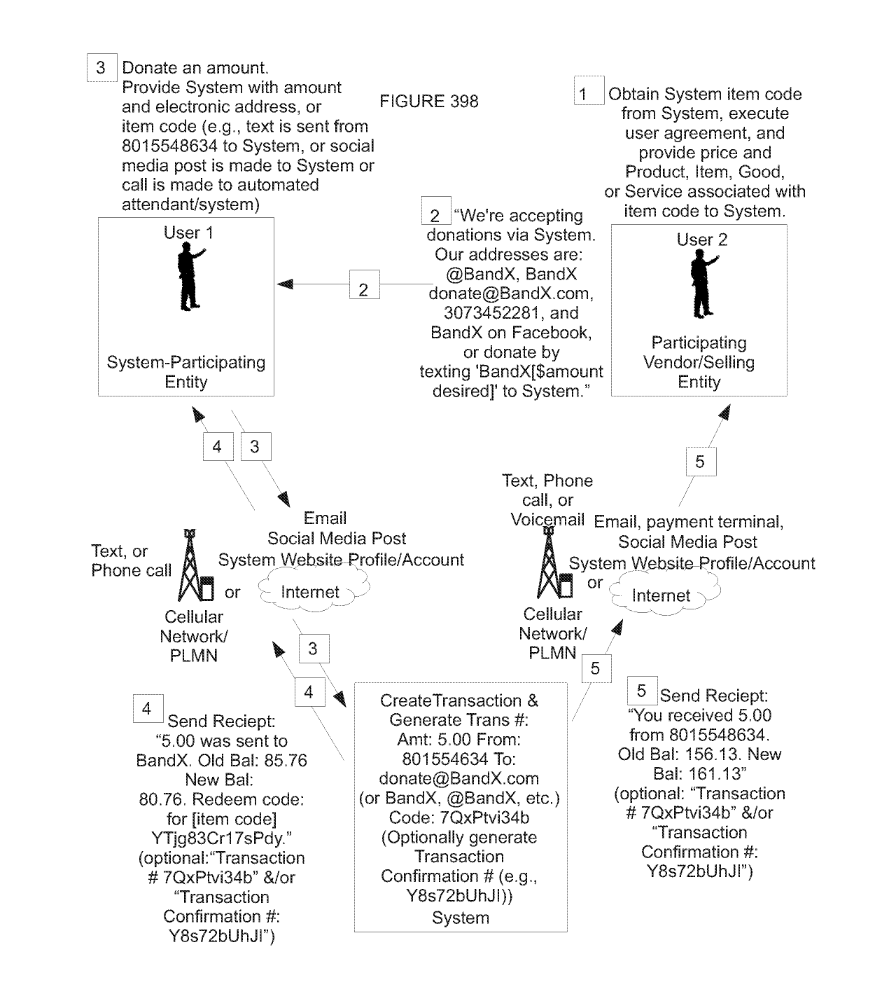

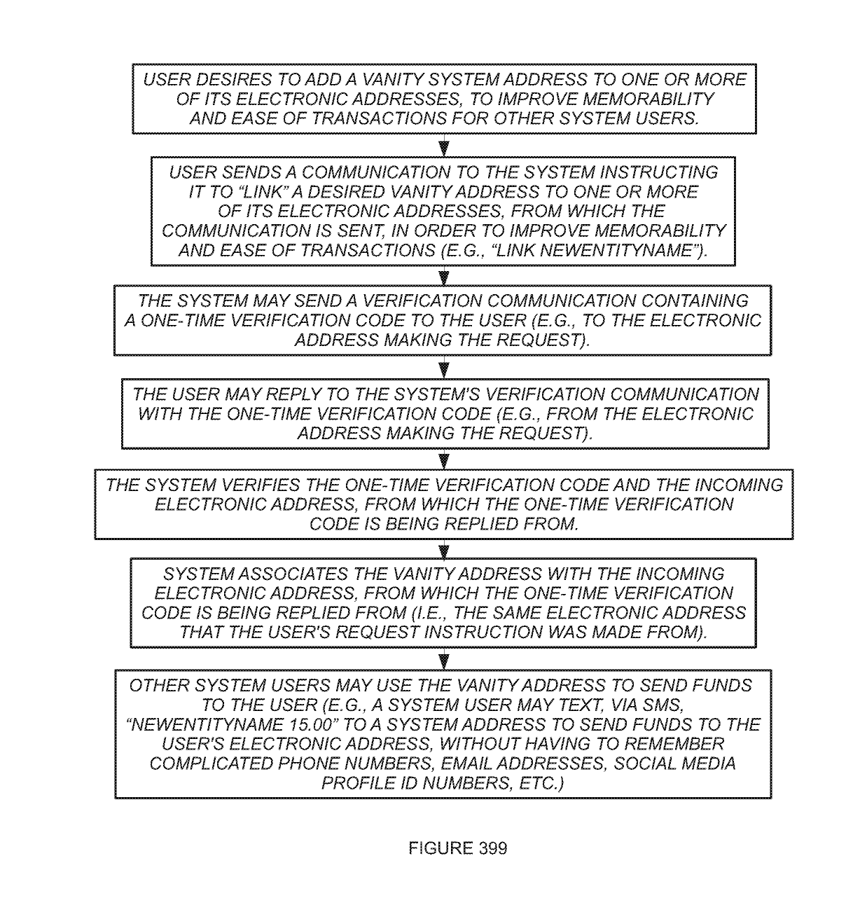

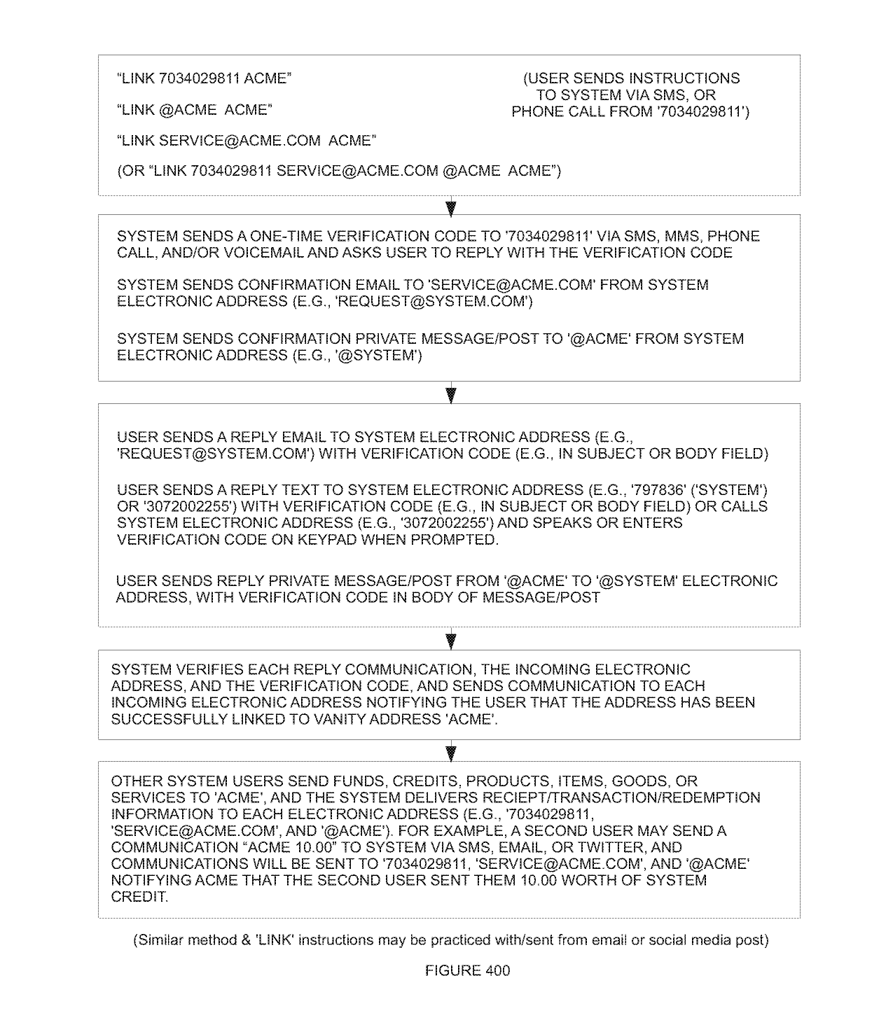

According to some embodiments, a user may provide a “link” command or the like, in an electronic communication to a component of the system, for example, to add an electronic address to an existing system user account 48, profile 130, or to one or more other electronic addresses already in use. This may, for example, be appreciated from FIGS. 344, 345, and 601, without limitation. In some embodiments, the electronic address desired to be added (e.g., to an existing system user account 48, profile 130, or to one or more other electronic addresses already in use) may be provided in the same communication which contains the command, without limitation. In some instances, a link command may be provided alone in an electronic communication to a component of the system, and provide the electronic address to be added in a subsequent electronic communication, without limitation. It may be appreciated from the figures that a link process or a link transaction may require interaction on multiple platforms (e.g., a platform utilizing the electronic address which originates the link transaction request electronic communication, and a platform utilizing the electronic address to be added), without limitation. Linking electronic addresses may expand system functionality for users and may, in more preferred embodiments, allow users to perform electronic requests using different platforms, may allow users to receive funds or credits to their system account 48 or profile 130 from other users and/or participating entities 65 via different electronic address information, and/or may enable consolidation of separate user accounts 48 or profiles 130, without limitation.

For example, in some embodiments, a user 91 having an active/activated mobile account 48 may be able to use their system account 48 to purchase, send, and/or receive funds or credits (e.g., redemption information 64) by email, by using the link command. The user may provide the link command in combination with the user's email address, and then follow the provided system instructions to complete the transaction (e.g., output 5). By linking the user's 91 email address to the user's 91 mobile number, the user 91 may have the ability to send funds and/or credits to any person 92 via the user's 91 email address. By linking the user's 91 email address to the user's 91 mobile number, the user 91 may have the ability to receive funds and/or credits from any person via the user's 91 email address. In some embodiments, only one email address and only one mobile number may be permitted per system account 48 or profile 130, without limitation. In some embodiments, an account may have more than one type of electronic address (e.g., more than one mobile number, more than one social media address, more than one email, etc.), without limitation. In some embodiments, users 91, 92 may share a single account, for example, by linking electronic addresses of different users 91, 92 to the same account 48 or profile 130.

In some embodiments, if a recipient 92 of funds or credits delivered by a user 91 isn't a member, an account may be created for them by system components. In preferred embodiments, the recipient 92 of funds or credits may be able to use the funds or credits immediately, for example, to purchase items, products, goods, or services for themselves, or for others, or re-gift received redemption information 64, without limitation. In some embodiments, one or more instructions may be provided to a user to verify accounts, confirm transaction requests, and/or validate electronic addresses, without limitation. In some embodiments, the risk associated with providing incorrect recipient information may be entirely held with the sender/requesting user (e.g. per user agreements), without limitation. For example, if a requesting user provides a recipient electronic address (e.g., email address) that is old, inactive, incorrectly typed, or otherwise invalid, and an electronic message delivered from the system to the recipient electronic address is not returned to the system, then system components, may, in some embodiments, conduct the transaction as if the provided recipient electronic address was valid, without limitation. Any number of confirmation requests, or other messages comprising instructions may be sent back and forth between system components (e.g., between a system-integrated server 122, 125, 128, 136 and a mobile device 96 or computing device 95 of the sending user 91, or between a system-integrated server 122, 125, 128, 136 and a mobile device 96 or computing device 95 of a recipient 92), in order to reduce error and improve platform robustness, without limitation. In some embodiments, users may be discouraged from replying to numbers that are not known, for example, if phishing attacks are presumed. Accordingly, while it is conceivable that the inventive technology may employ a “request” command (e.g., to allow a user 92 to request funds and/or credits from one or more other users 91) such functions may be more appropriately suited for certain platforms (e.g., a system mobile application 147) than others. Users 91, 92 may employ more conventional communications (e.g., P2P, phone call, direct SMS messaging) to request funds or credits from other users, and then utilize system components to perform the requested task, without limitation. For example, in some embodiments, users may communicate through their own network providers and personal person-to-person correspondence, to ask for credit or a gift, and then utilize system components to deliver the credit or gift, without limitation. In this regard, senders and receivers alike, may know and/or expect transactions to occur and may rule out phishing tactics. Similarly, users may correspond directly through means other than that provided by the system, to confirm that received funds and/or credits were delivered and/or to confirm the identity of the sending user, without limitation. A conceivable scenario of a transaction using the inventive technology may comprise the following: person A calling, texting, emailing, Tweeting, or messaging on Facebook, person B; person A asking person B to send person A item code “ProductX” or “10.00” send1 credit, and then person B sending a request to the system (e.g., a command “[person A's electronic address]”, or a command “[person A's electronic address] 10.00”, or a command “[one-time verification code] 10.00” in the subject field of an email, and Cc: “[person A's email address]”, or a command “[one-time verification code] [person A's electronic address] productx”, or a command “[one-time verification code] [person A's electronic address] 10.00”, and/or the like), without limitation. The nice thing about utilizing email for system transaction requests, is that multiple recipients may be communicated to the system by providing multiple email addresses in the “Cc:” field and/or “To:” field. Since most email clients cache email addresses, transactions for multiple users (e.g., entire mailing lists), may be performed at once, in as little as a single communication, without limitation. According to some embodiments, every recipient email address may be copied to a “Cc:” and/or “To:” field. In some shown and more preferred embodiments, recipients may be listed in the “Cc:” field and the system electronic address (e.g., “request@send1now.com”, without limitation) may be listed in the “To:” field, for example, according to a non-limiting predetermined system convention, without limitation. It should be understood that recipient email addresses could alternatively be listed in the “To:” field, and a system electronic address could be provided to the “Cc:” field, without limitation.

While not shown in the figures, in some embodiments, a user having an active/activated email account 48 or profile 130 may, via email, link the user's mobile device 96 number (e.g., phone number). For example, a user may place the keyword “link” command, or the like, after a one-time verification code in the subject line, followed by the user's mobile device 96 number, without limitation. According to various embodiments, the link command may be placed anywhere in the subject field and/or body field. According to various embodiments, the mobile device 96 number may be placed anywhere in the subject field and/or body field. According to various embodiments, no one-time verification code may be necessary or otherwise provided in the email-based link request communication. Accordingly, if the user initially became a member of the system through email (for example, if someone sent the user funds and/or credits and the system automatically set up the user's account with just the user's email address), the user may be able to link their other electronic addresses. In some embodiments, the user may use the command “link” and their mobile device 96 number (e.g., a 10-digit US or Canadian-based mobile number, without limitation) in a link request communication to the system. It should be understood that other length mobile device 96 numbers may be used, for example, for use of system features and concepts in countries outside of the US and Canada, without limitation. Again, as stated before, it is anticipated that the particular order in which information is presented, or arranged, within system request communications may vary, without limitation, although conventions and/or protocols may be preferable. To assist users, communications made to users may provide all necessary instructions to complete a transaction, without limitation. In some embodiments, when a link request transaction communication is received by components 128, 147 of the system, the system may parse/process the communication contents and manipulate profile 130 information (e.g., account 48 information). For example, components 128, 147 may link funds associated with a user's email account, with a provided mobile account in an email request comprising a mobile device 96 number. In some embodiments, if a user is maintaining separate email and mobile accounts—each having different balances and/or redemption data 64 therewith, and the user wishes to consolidate the accounts (e.g., merge funds and/or credits into a single system account), the user may use the “link” command in an electronic message originating from either platform (e.g., email, mobile messaging, SMS, phone call) addressed to the system, and then follow the directions or instructions provided. In some embodiments, system components might send a one-time validation code to one or both platforms (e.g., the platform on which the “link” command was used, the platform from which the “link” command was sent to the system). In some embodiments, a one-time validation code received on one platform (e.g., received in an email within the user's email inbox) may be used within another communication sent to the system using another platform (e.g., sent to the system from the user's mobile device 96 via mobile messaging, SMS, or phone call), without limitation. Similar uses of the “link” command may include linking a Twitter handle electronic address, a screen name, a social media profile ID number, or the like, without limitation. For example, if a user sends a link request via email and includes his/her un-linked mobile device 96 number (e.g., cell phone number or, in some embodiments, a landline number) via email, a one-time validation code may be generated and sent by system components, to the user's email address, wherein the one-time validation code may then be texted to the system or provided to the system during a phone call to the system, using the user's mobile device 96, to complete the link function, without limitation. Alternatively, if a user sends a link request via a mobile device 96 number (e.g., cell phone number or, in some embodiments, a landline number) and includes his/her un-linked email address via mobile messaging, SMS, or phone call, a one-time validation code may be generated and sent by system components, to the user's mobile device 96 (or, in some embodiments, to the user's landline phone), wherein the one-time validation code may then be emailed to the system, using the user's email client (e.g., webmail), to complete the link function, without limitation.

In some embodiments, a user may provide a “cash” command (or equivalent), to trade received redemption information 64 (e.g., redemption codes or the like), for credit (FIG. 595), without limitation. A user may attach, for example, the word “cash” (or the like), and an unused redemption code, to exchange the unused redemption code for funds (e.g., a form of payment data 10). In some embodiments, system components may, by default, credit the user's system account 48 balance by an amount equivalent to an original purchase value of the redemption information 64. In some embodiments, the system may credit the user's system account 48 balance by an amount which is less than an original purchase value of the redemption information 64. For example, a portion of the difference in credit debited from the purchaser of redemption information 64 and the amount of credit applied during the exchange of the redemption information 64 may go to the system and/or the participating entity 65 associated with the redemption information (e.g., a transactional fee may be deducted automatically by system software components 147, and may be automatically applied to one or more accounts 48 within a system database 129), without limitation. It should be appreciated that a “cash all” command (or equivalent) may be used to convert all unused redemption information 64 associated with a user account 48 or profile 130 to another form of funds or credits, without limitation. It is also envisaged that a “cash” command (or equivalent) may be used in conjunction with one or more item codes pertaining to a user's unused redemption information 64 (e.g., in conjunction with or in lieu of redemption information 64), without limitation, wherein software components 147 of the system may search a user's profile 130 for unused redemption information pertaining to the provided one or more item codes, and exchange all matches for another form of funds or credits, without limitation. In some embodiments, a “cash” command may have alternative meanings, without limitation. For example, a “cash” command may, in some embodiments, serve as an instruction to the system to electronically deposit money into the user's financial institution 163 account, without limitation (e.g., “cash 15.00” may suggest “convert $15.00 worth of system credit to USD, and deposit it”, without limitation).

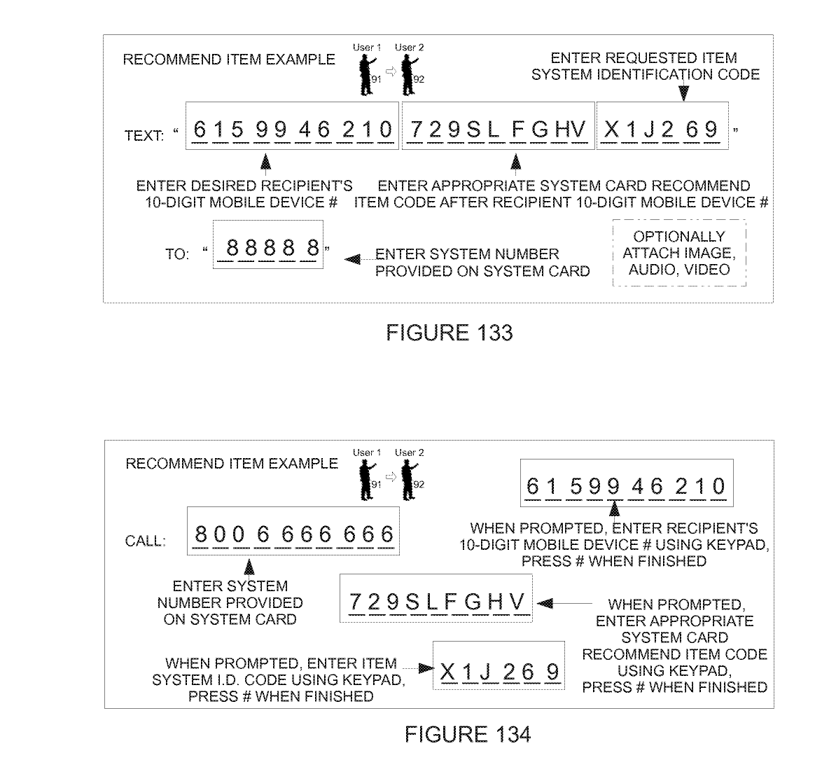

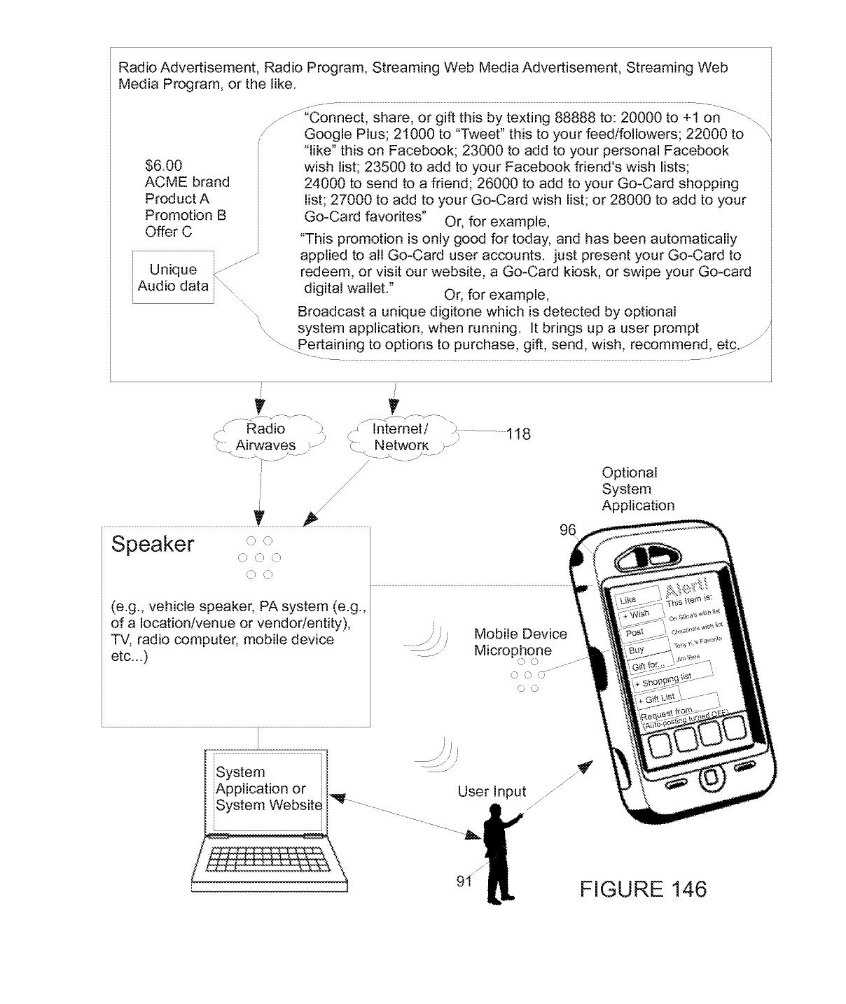

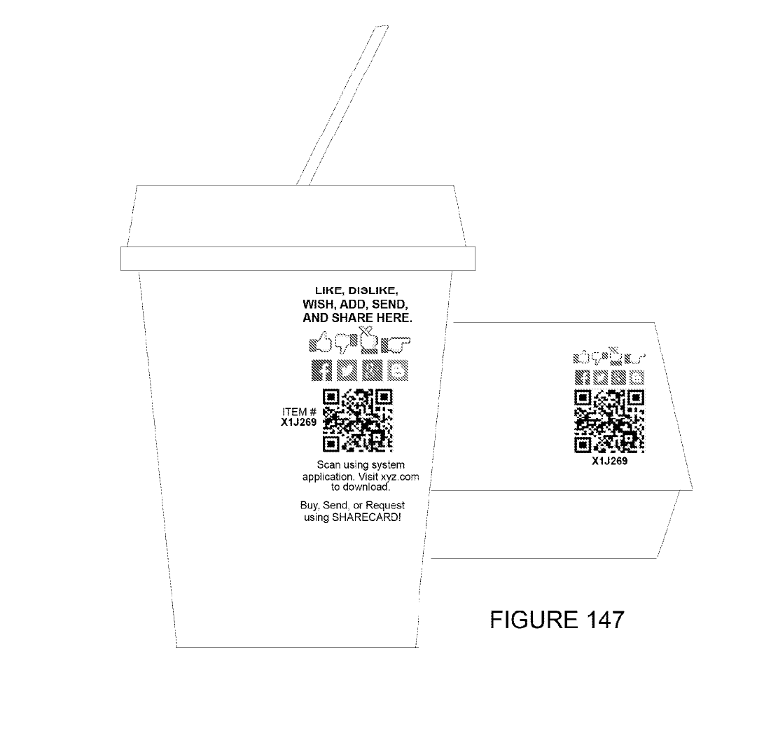

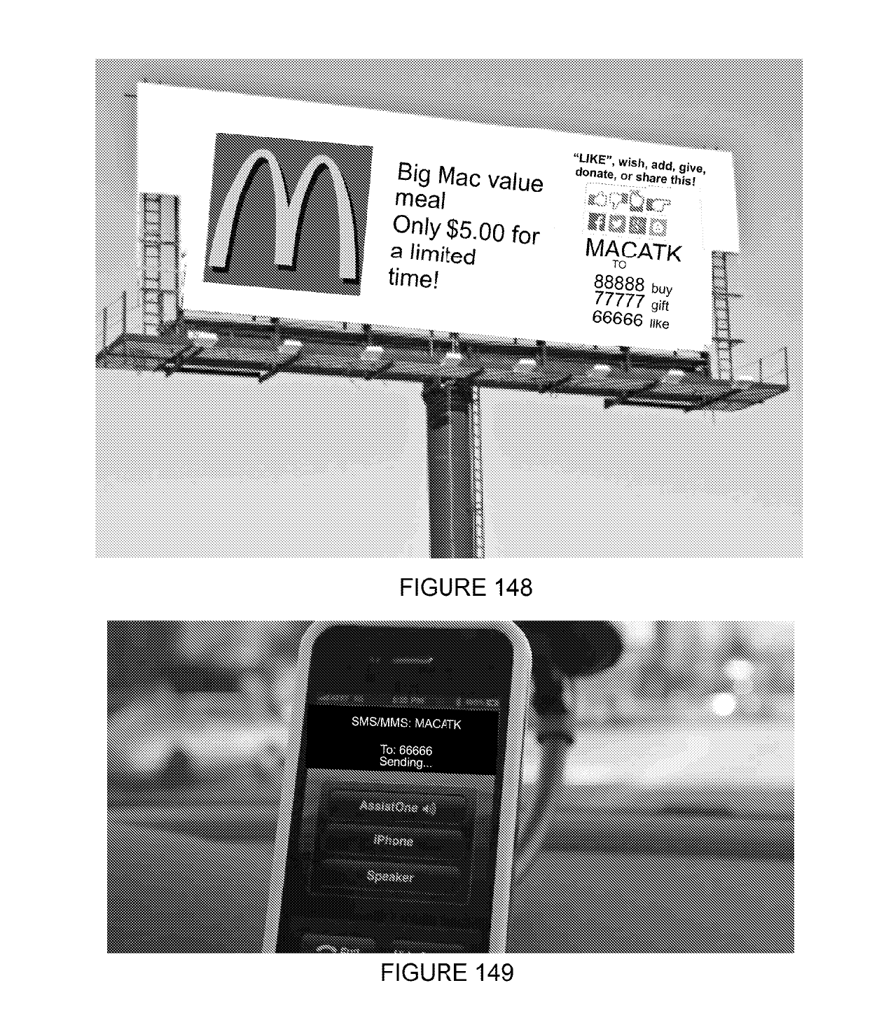

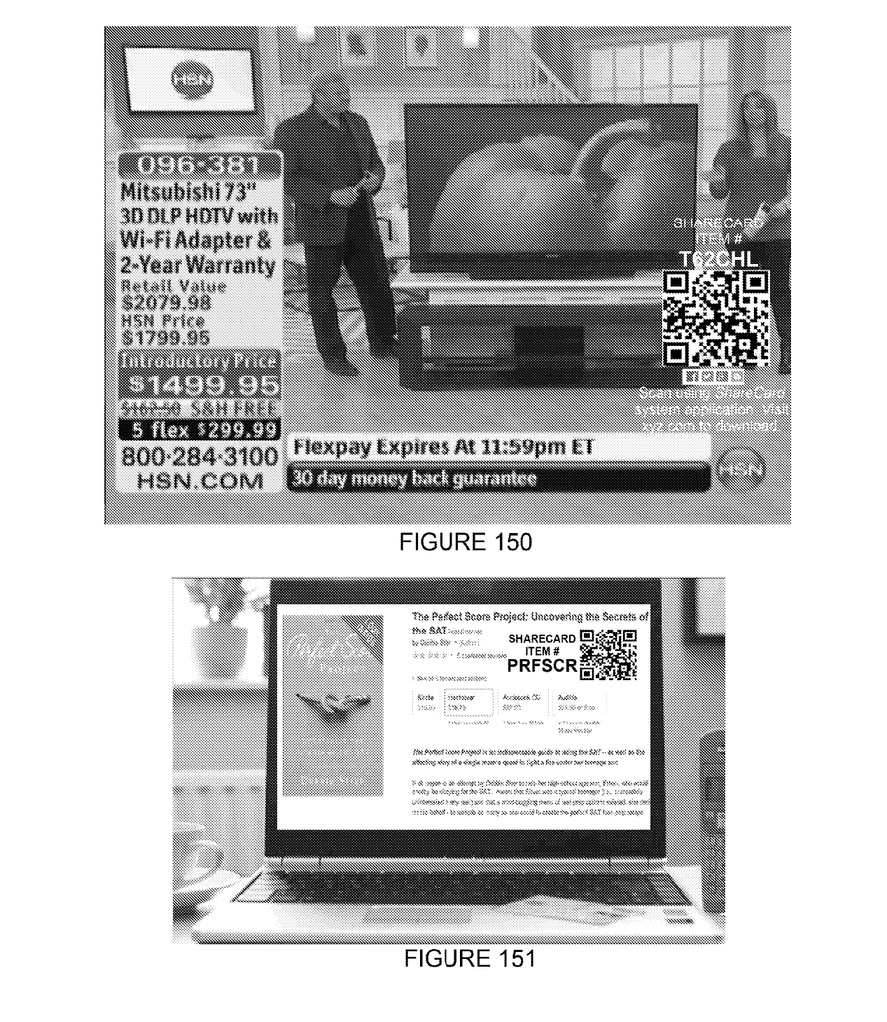

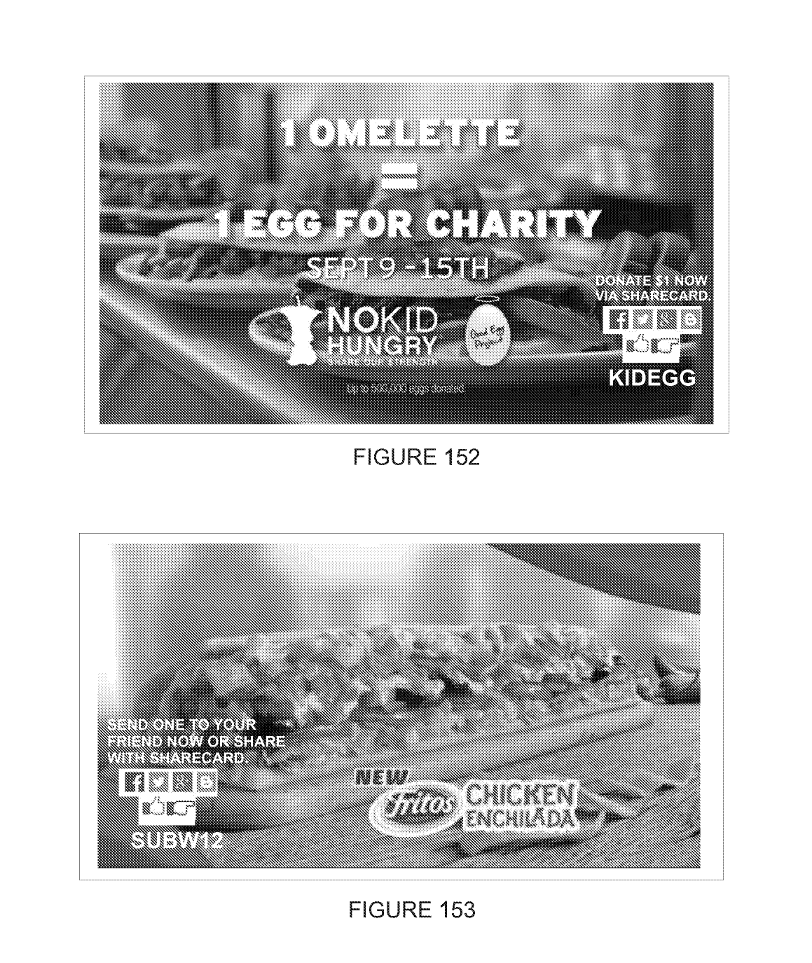

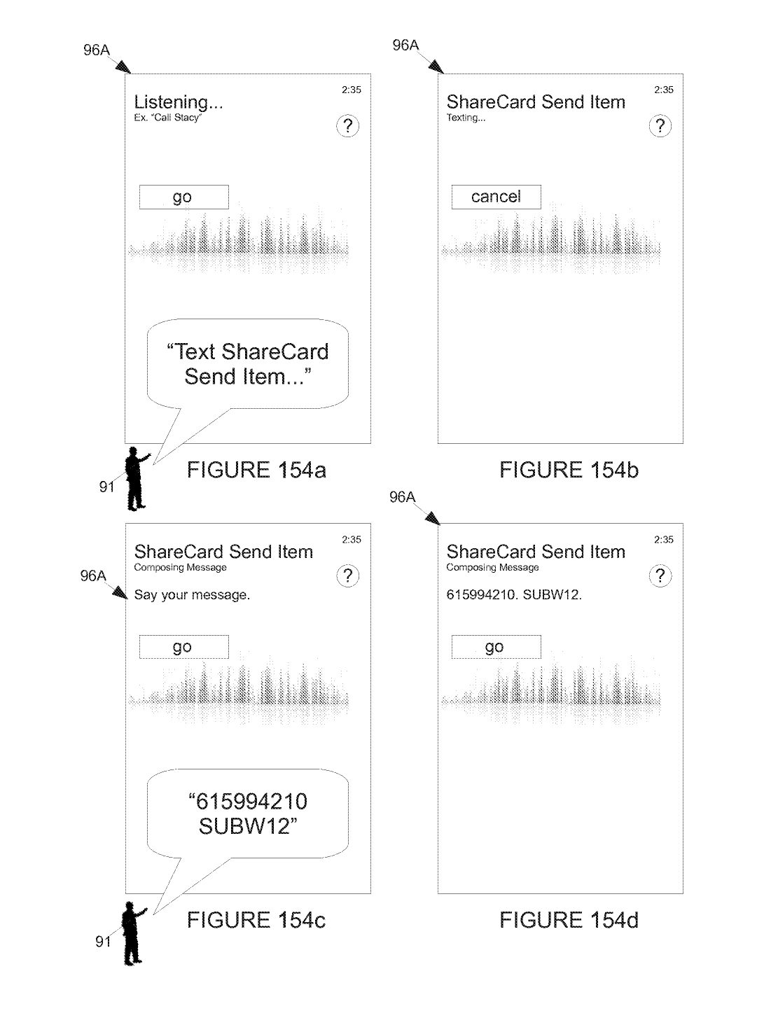

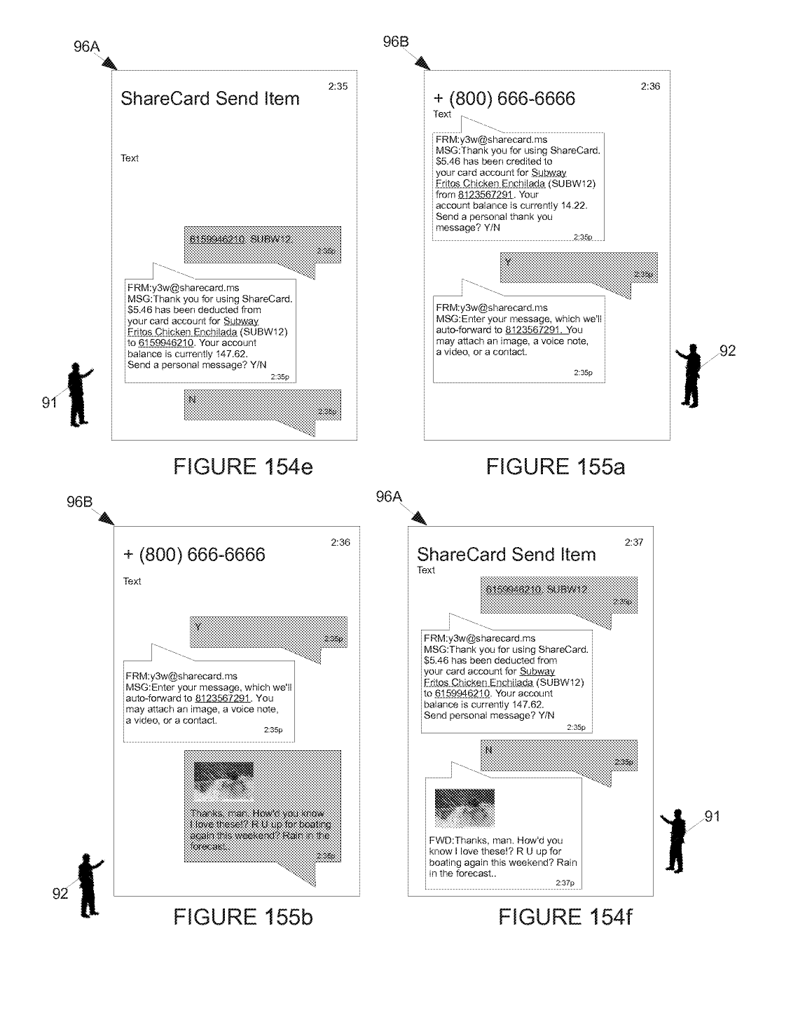

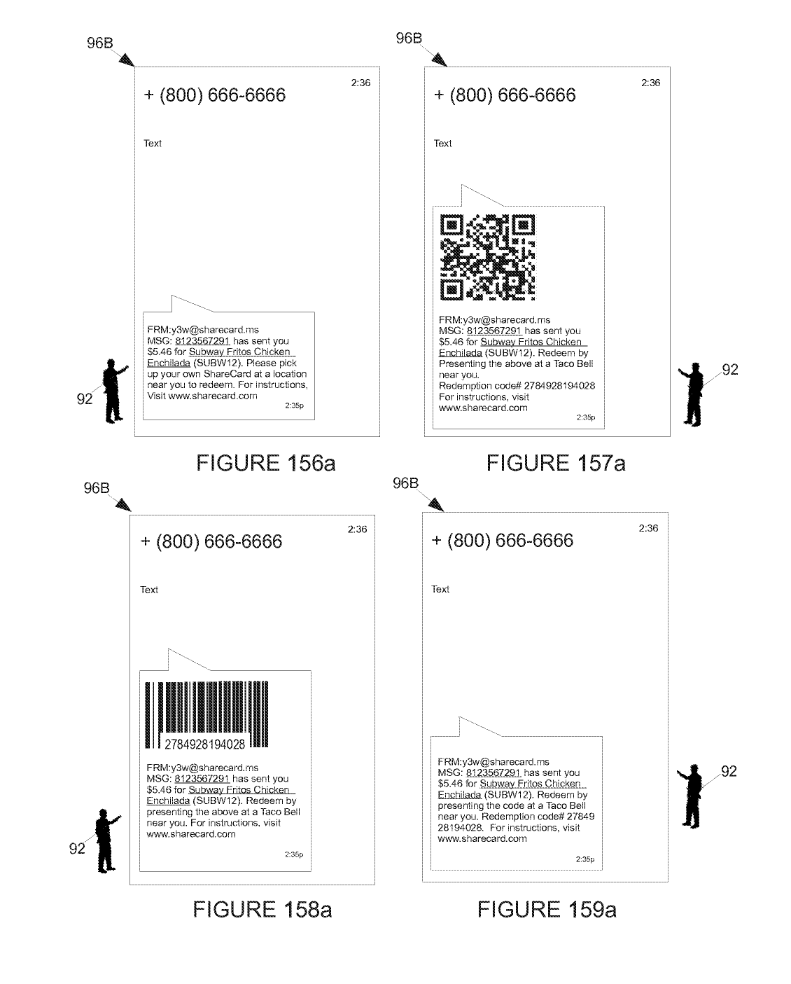

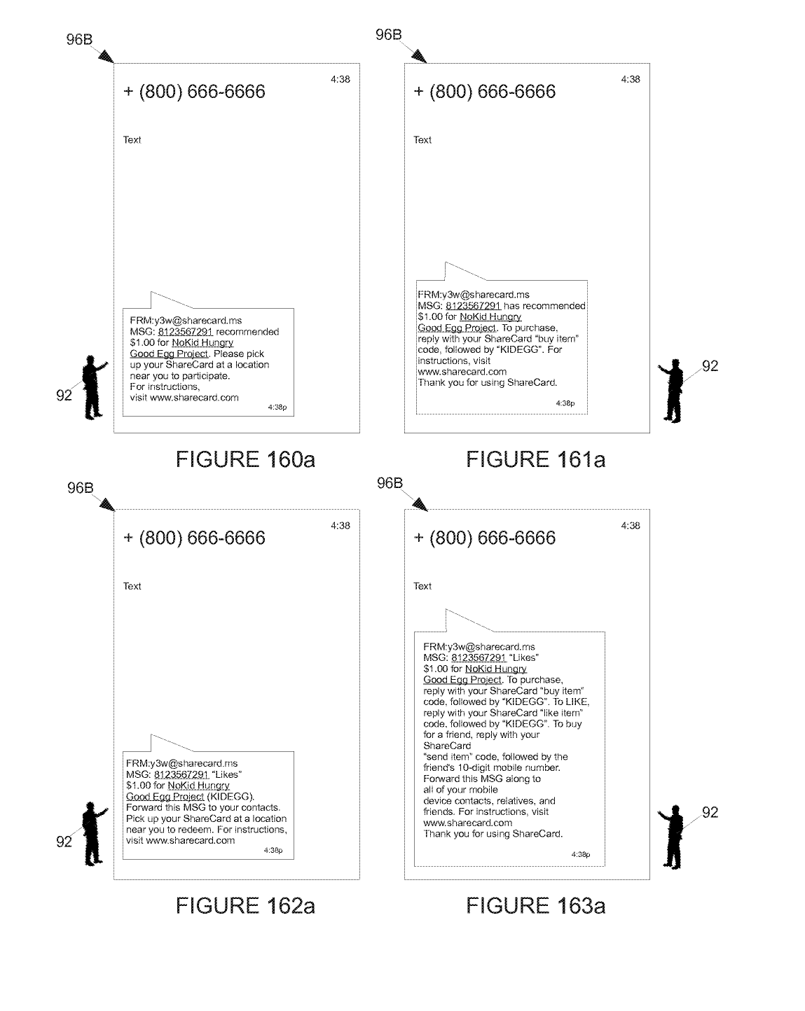

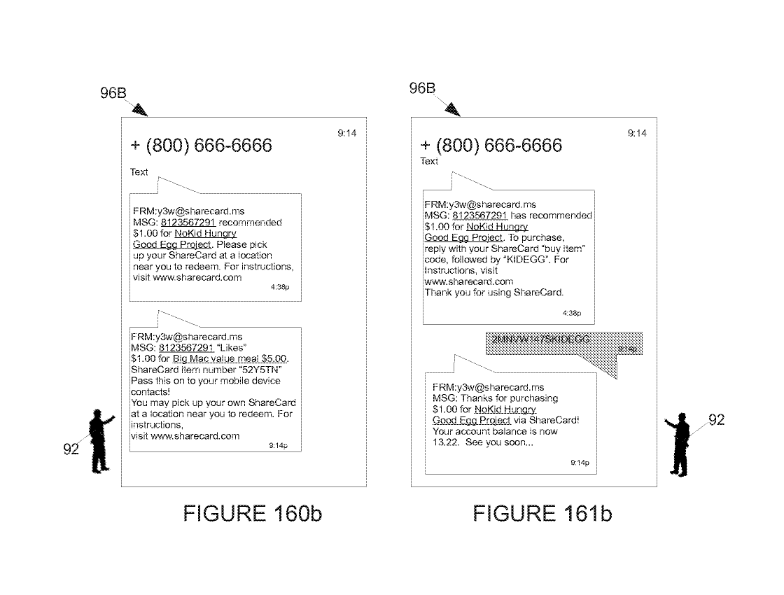

According to some embodiments, a user may shop, send a thank you, reconnect, and/or donate from the comfort of his/her sofa, for example, while watching television. This may be appreciated from at least FIGS. 150, 152, 153, and 182i, as well as FIGS. 133-148 of co-pending U.S. Provisional Patent Application No. 62/024,465, which are hereby incorporated by reference in their entirety. Item codes may be stored in a system database 129. In some embodiments, item codes may comprise “hashtags”, without limitation. In some embodiments, item codes may be affiliated with redemption information 64, cost information, and/or the like, without limitation. In some embodiments, item codes may be system-proprietary or third-party proprietary item codes, without limitation. Item codes may be displayed on commercials, during shows (e.g., product placements), may be talked about in social media, on the radio, and/or the like, without limitation. In some embodiments, users may text, email, call, or Tweet a system electronic address, and in the communication, may provide the item code and recipient information, such as a physical or electronic address. In some embodiments, the address may comprise a sender's address information, someone else's address information, address information pertaining to a group of people, a “vanity” system address, a list of addresses, one or more phone numbers, one or more screen names, one or more email addresses, and/or the like, without limitation.

According to some embodiments, a user may utilize system components and/or practice the inventive features and concepts, while shopping at the store. For example, a user 91, while window or aisle shopping, may see an item that someone would like, text the item code (e.g., GTIN-12 numerical barcode number) and the command “cost”, to a system short code, in order to determine how much system credit may be necessary to send the item to the recipient (or each recipient). The user 91 may text the command “b”, “bal”, “balance” or the like, to check how much system credit they have and determine if there are sufficient funds to purchase the item. The user may instantly electronically send the item to one or more recipients by providing the recipient information along with the item code (e.g., GTIN-12 numerical barcode number), to a system short code. System software components 147 may deduct a user's account 48 balance (e.g., which may be a third-party account balance, financial institution 163 account balance, or a system-specific account balance, without limitation) for each item purchased, and may send the redemption information 64 to the recipients so that they may exchange the redemption information 64 with a participating entity 65, to receive the item (e.g., via in-store pickup or online order/delivery, for example, on a website checkout page, without limitation). Recipients may immediately walk into a participating store to redeem redemption information 64 (e.g., a redemption code), which may, upon redemption, be voided and/or claimed by the participating entity 65 (e.g., merchant). In some embodiments, a claim code may be sent to the redeeming user (e.g., in real-time, via one or more system components 96, 106, 147), which may be necessary to give the merchant, in order to complete the transaction and exchange the redemption information 64 for a physical item, product, service, store credit, store gift card, and/or the like. In some embodiments, item codes may be placed on product packaging such as pizza boxes, milk cartons, wrappers, labels, backs, napkins, drink cups, plastic bags, receipts, tags, wrapping paper, tissue paper, etc., without limitation. In some embodiments, item codes may be placed around stores on signs, tags, labeling, shelving aisle markers, at checkout displays, near points of sale, etc., without limitation.

According to some embodiments, a user may utilize system components and/or practice the inventive features and concepts, while checking out online or in a store. For example, a user may text a transaction code to a system electronic address, or a user may text a transaction code to an electronic address provided on a website. Upon doing so, the user may receive a one-time verification code delivered, for example, via SMS (other platforms could be used as will be appreciated from this disclosure). The communication containing the one-time verification code may contain current balance information, a calculated or estimated prediction of balance information if the transaction is completed (e.g., post-transaction balance), and/or a notification of insufficient funds to complete the transaction (where applicable). The verification code may be inputted into an appropriate entry field on the merchant's checkout page (e.g., a checkout page). One or more tick boxes or additional fields may be provided on the merchant's checkout page to indicate whether the purchase is a gift, wherein a user may provide recipient physical and/or electronic address information, such as one or more electronic addresses (e.g., a recipient's phone (e.g., mobile) number, email address, physical address, vanity electronic address, Twitter handle, screen name, and/or other information including, but not limited to the recipient's electronic address information). QR codes may be displayed for interaction with a system application 147 (e.g., scanning), which may process payment and complete the transaction in general. The application 147 may be a mobile application for a mobile device 96 or may be installed on a computing device 95, such as the computing device 95 displaying the web page, but having an external camera, without limitation. Voice commands may be utilized (e.g., with the mobile app and/or computing device 95 software application 147) to speed up the process. Codes and/or instructions may be provided on the checkout page, which may be used with a system application to complete a transaction (e.g., a purchase function or a gifting function). Similar protocols may be utilized on non-checkout web pages. System icons or widgets may accompany or otherwise be placed adjacent to items for sale which are displayed on an online electronic commerce website. Scannable, machine-readable indicia may accompany or otherwise be placed adjacent to items for sale which are displayed on an online electronic commerce website; wherein, when scanned by a mobile device 96 comprising a system application 147, may trigger a system application prompt to buy, gift, like, etc., via the system and components thereof. In some embodiments, redemption information 64 or portions of redemption information (e.g., a redemption code and/or PIN) may be entered into existing “promo code” or “coupon code” fields; wherein in some embodiments, the total balance for the checkout page may be reduced by the appropriate amount (including, but not limited to 100% discounts, or “free”). Entered redemption codes may comprise a representation of any one or more of: an amount of vendor store credit, an amount of system credit which is accepted by the vendor as valid payment, and/or a prepaid voucher for an item, product, good, or service being displayed on the checkout page. When a redemption code is provided, and applied, the checkout page may subsequently remove the item cost from the total cart value, without limitation. This may be performed, for example, by the website host server communicating with a system database 129, 137 and/or system software 147, without limitation.

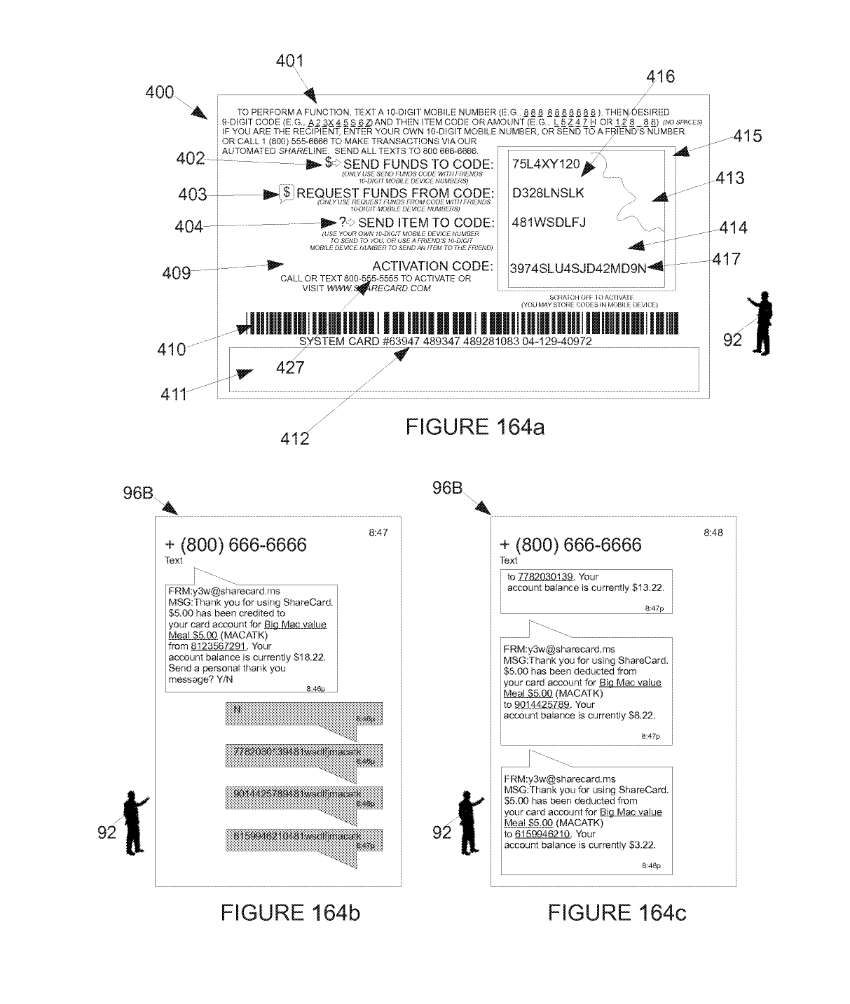

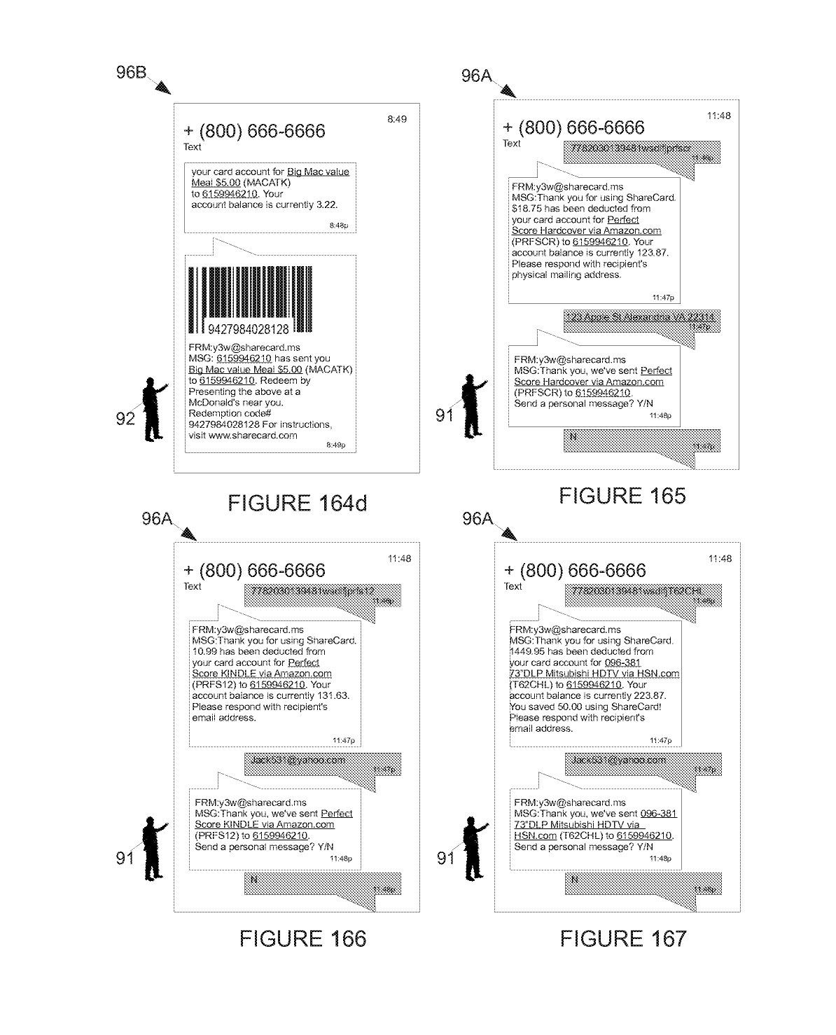

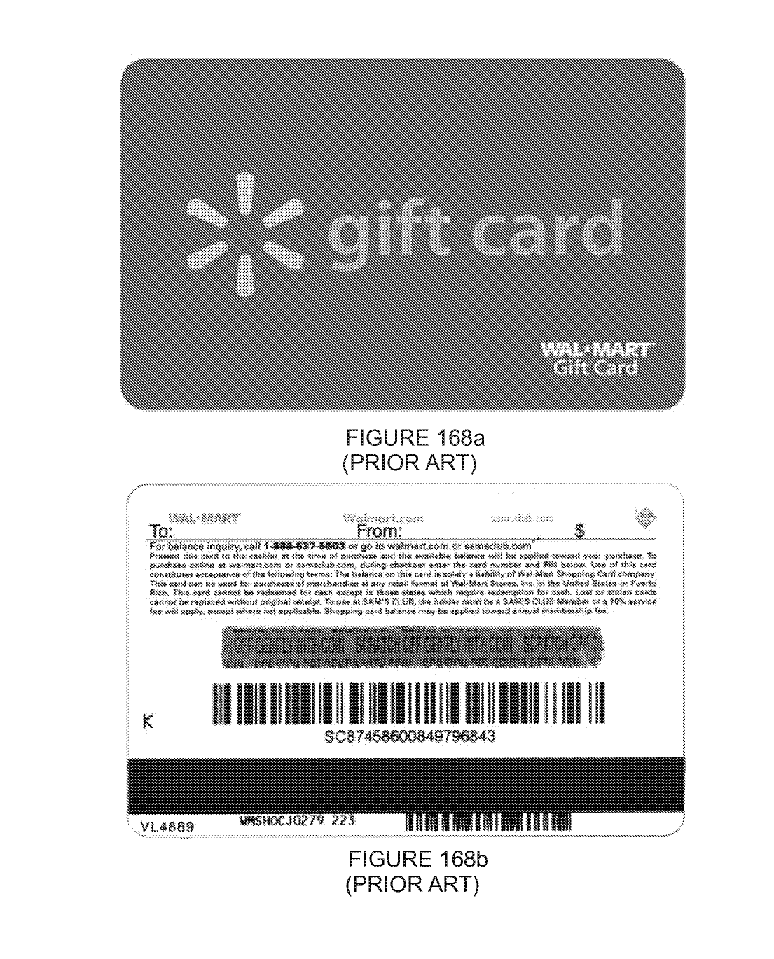

According to some embodiments, a user may utilize system components and/or practice the inventive features and concepts with gift cards, as may be appreciated from at least FIGS. 164a and 172. The inventive technology may be practiced with any store gift card 19 or pre-paid card 19 (e.g., a VISA gift card), without limitation. Credit associated with the card 19 may be applied to a user's electronic address or mobile device 96 in general, for example, by the user texting the activation code, PIN, and/or card number, to a system short code, email address, or long code after purchase, without limitation. Alternatively, the user may provide similar information my calling a system long code. Caller identification techniques, as well as user inputs 4 may be received and/or processed to verify a user's electronic address associate the account credit with the user's electronic address (e.g., mobile device 96 number). It is envisaged that activation may also be performed via the email, social media, or web-submission-based protocols described herein, without limitation. In the particular non-limiting embodiment shown, a card 19 component is configured to link a mobile device 96 number with a value associated with the card, for example, in a manner which may allow future transactions to be made with the user's mobile device 96, using funds associated with the card 19, without limitation. The user may send a portion or all of the gift card credit associated with the gift or pre-paid card to another user by following instructions provided on the card 19. In some embodiments, the user may purchase an item, product, good, or service with the card 19 (e.g., within a store of a respective vendor, if the card 19 is affiliated with the respective vendor). The user may see an item within a physical or online store, and follow the instructions on the gift card or pre-paid card to gift the item to one or more other individuals. In some embodiments, the user may see an out-of-stock item in a store, and order it for delivery or in-store-pickup. In some embodiments, the user may text the card PIN and/or card number (or other code provided to the card 19) within a transaction request. The transaction request may be made to a system address provided on the card 19. In some embodiments, these and other functions described herein may be handled entirely through a participating entity 65 (e.g., “licensed send1 technology” or “powered by send/technology”). In some embodiments, the user may, in a transaction request, include recipient information, such as one or more recipient physical or electronic addresses (e.g., one or more phone numbers, email addresses, Twitter handles, social media profile IDs, screen names, or the like), without limitation.

According to some embodiments, a user may utilize system components and/or practice the inventive features and concepts while reading a magazine. Vanity item codes may be applied to reading material, promotional material, or any type of printed matter material. The vanity item codes may be placed in, for instance, magazine advertisements so that users may be able perform gifting functions while waiting, for example, in a waiting room (e.g., doctor's office or auto repair shop). QR codes, bar codes, and the like may not be necessary; however, as demonstrated in the appended drawings, they may be provided for use with a system mobile application in some embodiments. For example, in some embodiments, a user may scan a machine-readable code with a system mobile application 147 and select, via a user interface 106 what he/she wishes to do with it. One or more prompts for instructions (e.g., Gift it? Buy it? Like it? Add to a digital shopping list?, etc.) may be displayed on a mobile device 96 supporting the mobile application 147. According to some embodiments, indicia may be provided to notify the user of the mobile application that an item, product, good, or service will be paid for by the user. According to some embodiments, indicia may be provided to notify the user of the mobile application that redemption information 64 (e.g., in the form of one or more redemption codes which may be in alphanumeric, audio-based, and/or image-based in nature) pertaining to the respective item, product, good, or service will sent to a recipient. Redemption information 64 may comprise, without limitation, a scannable/machine-readable image. Redemption information 64 may comprise, without limitation, a pre-paid voucher for the respective item, product, good, or service, etc.

According to some embodiments, a user may utilize system components and/or practice the inventive features and concepts while listening to the radio. Item codes may be communicated through audio communications via means for delivering audio outputs . . . for example, on the radio, on streaming media websites (e.g., Pandora), on DVD's, CD's, MP3's, Podcasts, and other tangible audio formats, without limitation. Disk jockeys or voice-overs may provide instructions, such as cost, value, and what the item code might comprise and/or functions which may be associated with the item code. According to some embodiments, an item code may be used in various transactions, for example, transactions comprising one or more of the following, without limitation: donations, purchases, and/or signing up/registering for events, wherein costs may be incurred and automatically deducted upon item code use, or wherein no costs may be incurred, without limitation. Item codes may serve as means for people to perform various functions including “liking” things using system components, adding things to wish lists, and/or recommending things, without having access/ability to manipulate a phone while driving (e.g., voice command social functions, voice command social commerce, voice command electronic commerce, etc.).

According to some embodiments, a user may utilize system components and/or practice the inventive features and concepts as a substitute for, or as a safe alternative to cash, without limitation. If a user is short on cash, he/she may send funds and/or credits to others using system components. A user may use system credit to buy things for themselves or for others. In some embodiments, system credit may be traded into another monetary form (e.g., USD or cash) by participating entities 65, who may then submit one or more physically mailed claims and/or one or more electronic claims to the system for reimbursement. The system may send a check or electronic payment to the respective participating entity 65 upon receipt of a physical or electronic claim. The system and/or the respective participating entity 65 may deduct or charge a transaction fee for converting virtual to physical currency and/or vice-versa, without limitation.

According to some embodiments, a user may utilize system components and/or practice the inventive features and concepts while on the road. System-recognizable item codes may be placed on vehicles, trailers, signs, paper billboards, electronic billboards, balloons, buildings, overpasses, and other displays commonly seen on roads, without limitation. Users may utilize the system electronic commerce platform while driving on the road, or while riding as a passenger on the road, as well as on other forms of transportation (e.g., rail, public transport, etc.). While not expressly shown, system “games” utilizing item codes may even be employed to provide entertainment on road trips. Location-based data may be utilized as a component of system “games”. For example, in some embodiments, system riddles, tick-tack-toe puzzles, or other amusement devices including instructions, may be posted on signs or other roadside indicia. In some instances, users may look for system logos and text the appropriate numbers or letters to a system electronic address as they appear. The item codes, when texted to a system electronic address (with or without additional commands), may reveal clues or contain hints to riddles. Information may be received by system components (e.g., user inputs 4 may be received by a system server 128, and system outputs 5 may be received by users via one or communications to their mobile device 96). For example, texting a correct answer to a riddle or question, to a system electronic address may trigger a script instruction which sends the player redemption information 64 (e.g., a redemption code for a free drink, toy, snack, or prize). Sent redemption information 64 may comprise regional redemption information, for example, to local participating entities 65 such as gas stations, convenience stores, and/or retail shops in the area of the paper billboards, electronic billboards, balloons, buildings, or overpasses containing the various parts of the “game”. Location-based data may be based on a user's electronic address (e.g., area code), or via other positioning system (e.g., triangulation), without limitation. This may help drive incremental sales to local establishments, and/or persuade users to stop at a particular participating entity 65 venue/location 2, in order to redeem received redemption information 64, without limitation. Similar tactics may be employed for non-amusement uses, such as to obtain coupons, discount codes, points, etc., without limitation.

According to some embodiments, a user may purchase system credit online, or may maintain privacy and/or minimize a digital footprint by reloading a system account with cash (e.g., in-store) or cryptocurrency, without limitation. According to some non-limiting embodiments, credit may be purchased online, via a system website 127, online through third party gift card exchanges, and/or wherever physical or electronic gift cards/prepaid cards may be purchased or sold. For physical cards 19, activation may occur at the register, for example, using P-O-S terminal communicating with a system database 129; wherein after a card has been paid for, a user may enter (e.g., via a user interface 106 or kiosk 3 operably coupled to the P-O-S terminal) one or more electronic addresses, one or more physical addresses, and/or other user data 8, without limitation; and wherein the information provided as a user input 4 is communicated to the system database 129 (e.g., via a network 118, system server 128, and a system application 147). Activation may occur by the store employee asking for the customer's phone number or email address and communicating it with a system server via a user interface 106 provided to a P-O-S terminal communicating with a system database 129. Activation may occur within a kiosk 3 environment, for example, a kiosk 3 configured to produce a card 19 to a user 91, 92, which may communicate with a system database 129 (e.g., via a network 118, system server 128, and a system application 147), without limitation. Or, as shown in the figures, activation may occur in private, after purchase, for example, by texting or calling a system electronic address and providing one or more user inputs 4 as instructed, without limitation. According to some non-limiting embodiments, texts may be sent to a system email address (e.g., “request@send1now.com”), to a system long code (e.g., “307-200-2255”), and/or to a system short code (e.g., “73631”), without limitation. For electronically-purchased cards 19, a purchasing user may provide their own electronic address (e.g., mobile number, social media handle, email address, etc.), or, in some instances, an electronic address of a recipient, without limitation. Users may, in some embodiments, need to provide at least one electronic address. In some embodiments, upon successful checkout, all of the one or more electronic addresses provided may be instantly populated within a system database 129, and may be associated with the purchased credit. In some embodiments, the purchased credit may comprise “re-load” or “top off” credit. In some embodiments, users purchasing credit may provide one or more recipient electronic addresses, for example, if the credit is a gift. In some embodiments, if multiple recipient electronic addresses are provided, and some of the recipient electronic addresses belong to different users 91, 92, each of the different users may have access to the purchased credit, without limitation. In some embodiments, if multiple recipient electronic addresses are provided, and all of the recipient electronic addresses belong to the same user 92, the recipient may utilize the purchased credit in transactions originating from electronic communications made from each of the recipient electronic addresses, without limitation. Alternatively, in some embodiments, the user may purchase credit for their own account 48, and may subsequently make a transaction request to the system to deliver some or all of the purchased credit to one or more recipients. In some embodiments, multiple users may share credit associated with the same account; for example, by providing one electronic address from one individual, and linking, via the “link” command or equivalent command, other electronic addresses from other individuals, without limitation. Such embodiments might be desirable, for instance, for use within a family, a club, an association, an organization, and/or a small closely-knit group of friends and/or co-workers, without limitation.

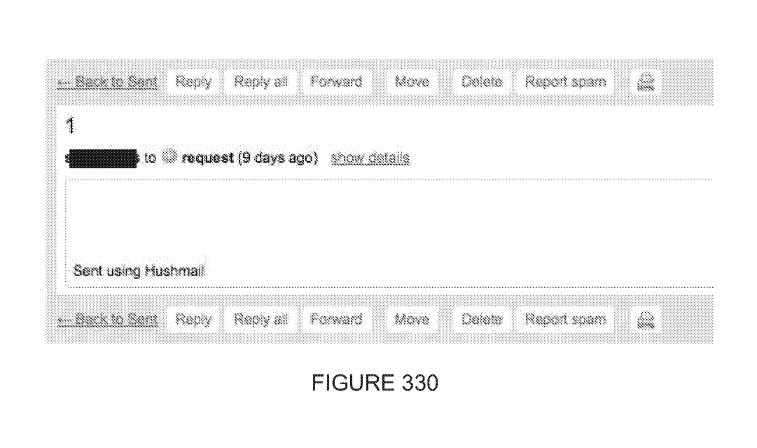

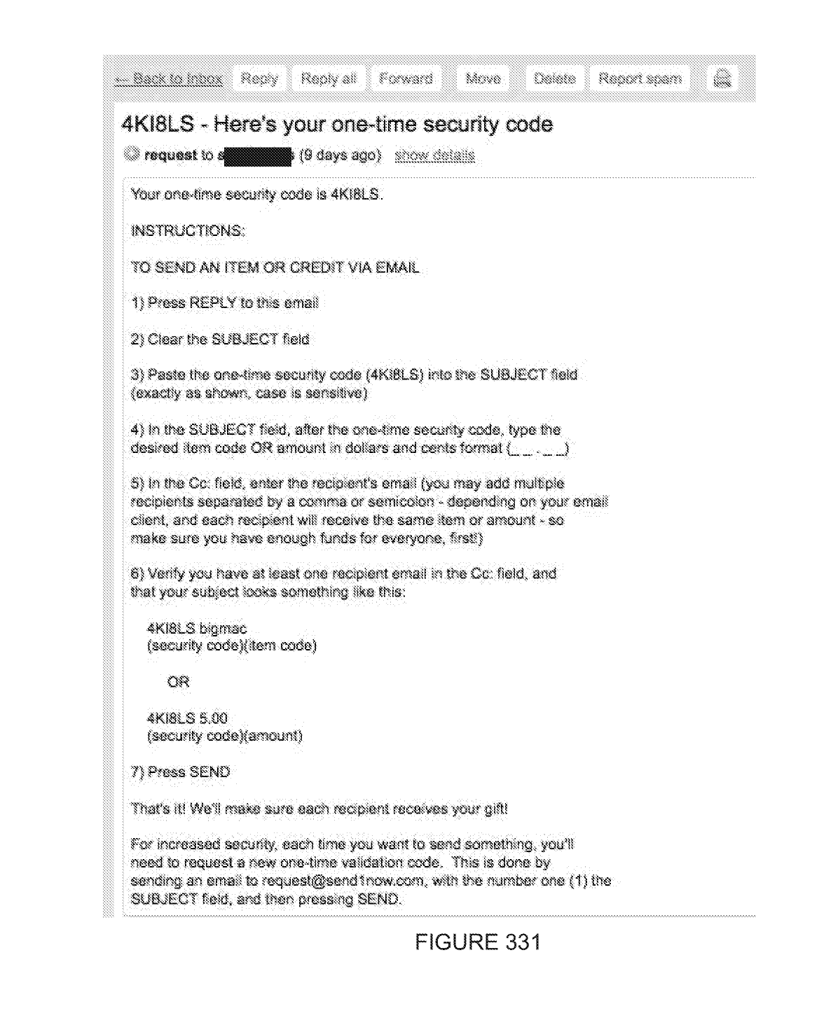

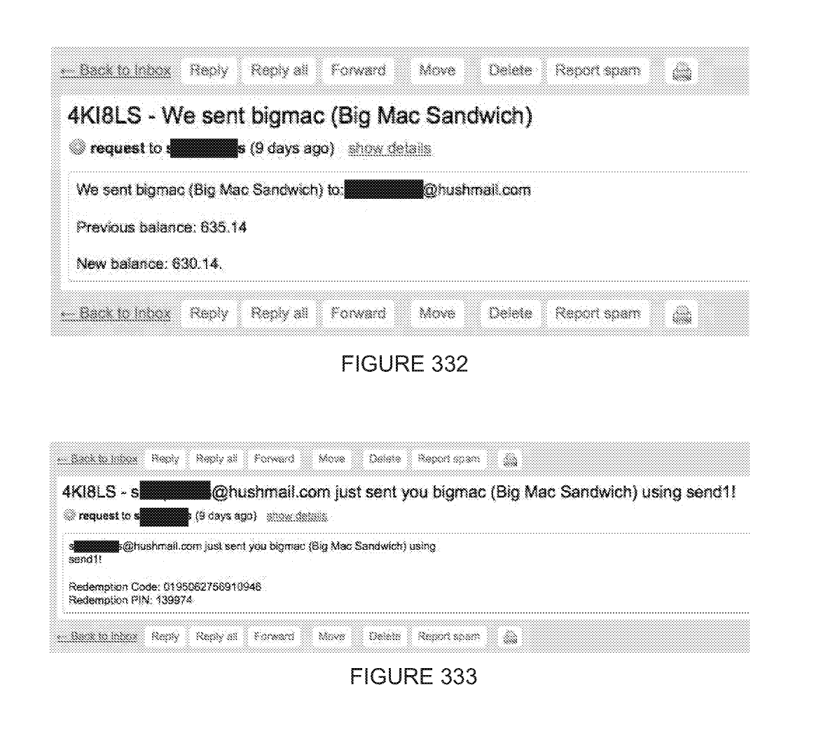

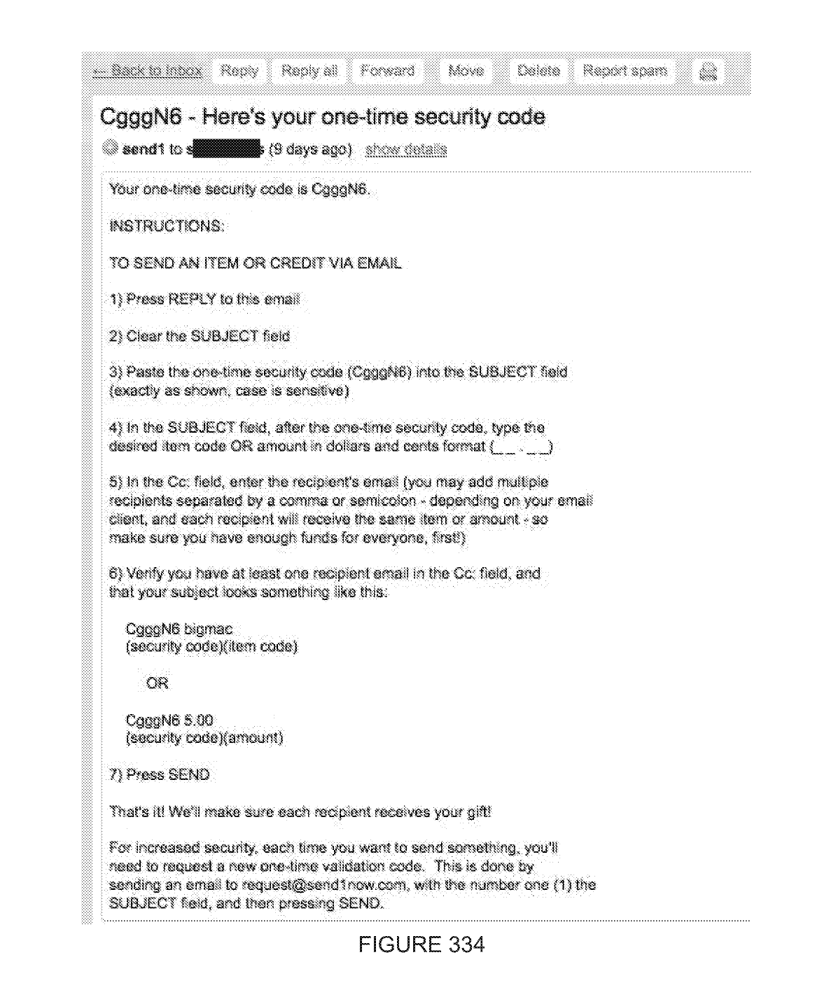

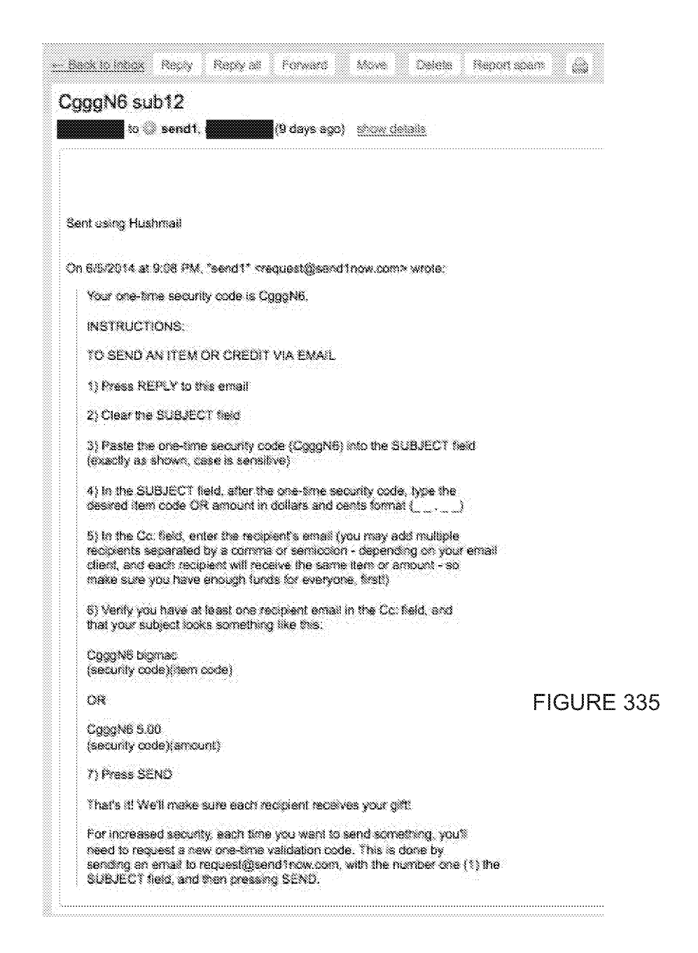

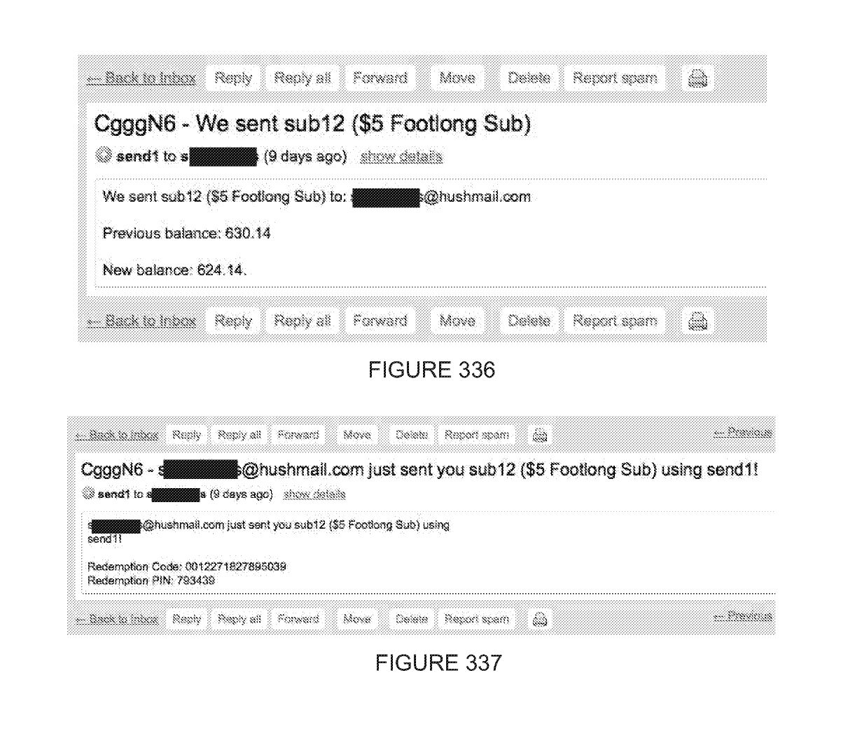

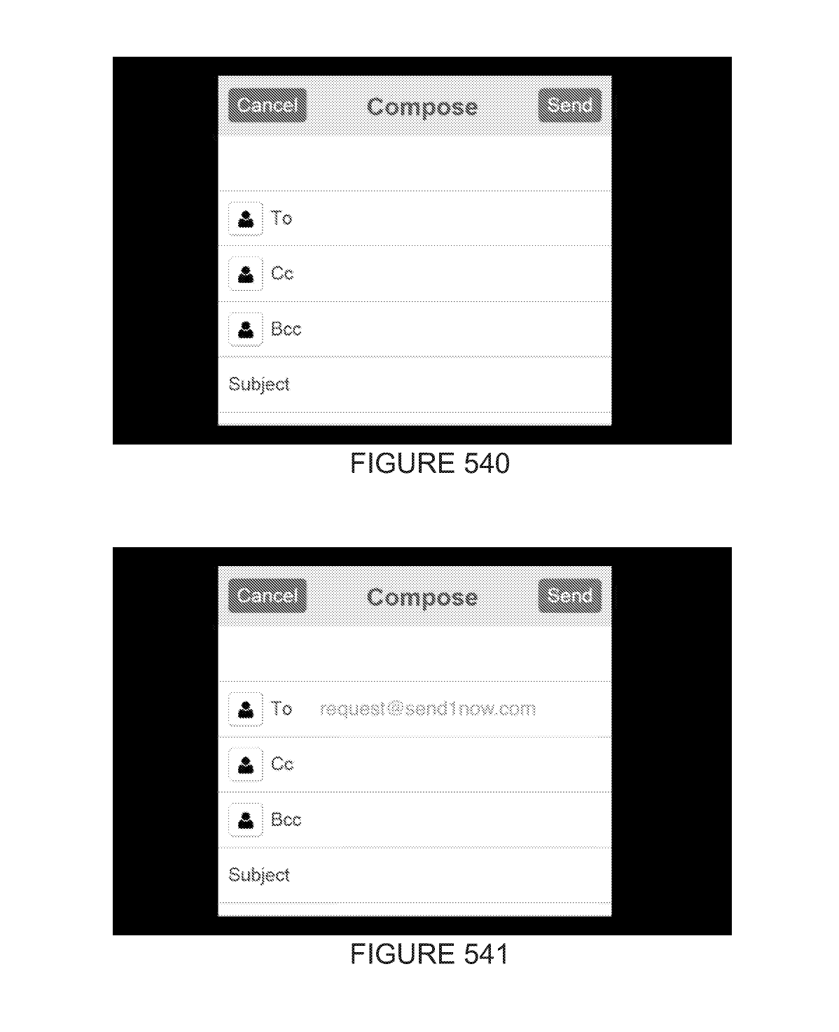

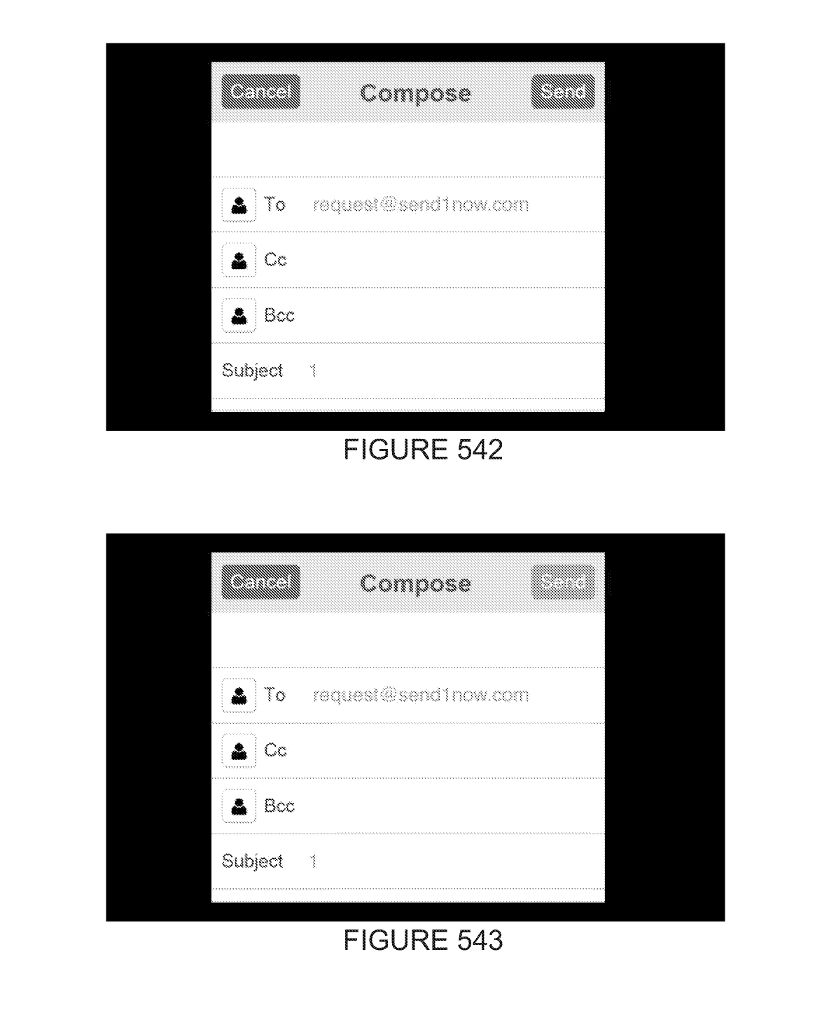

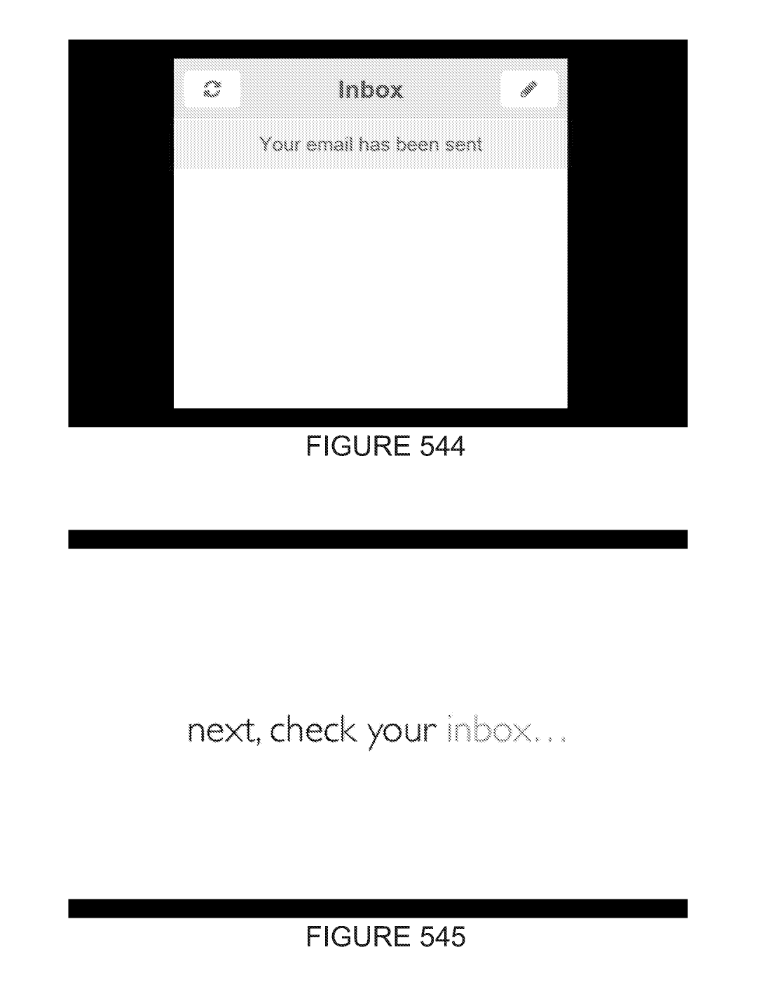

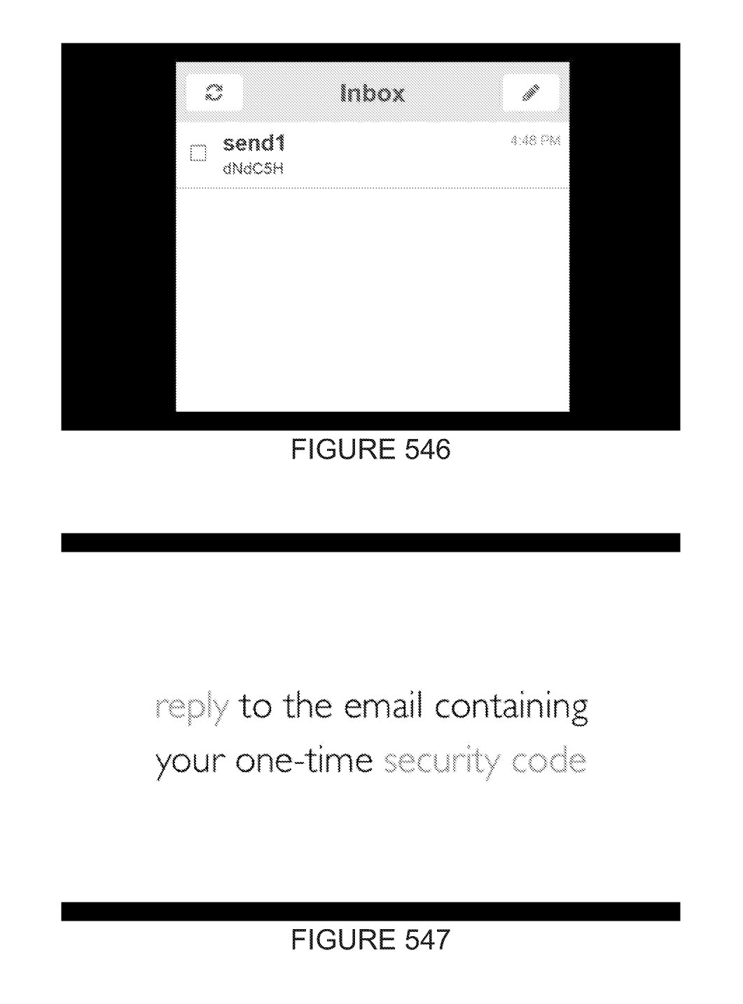

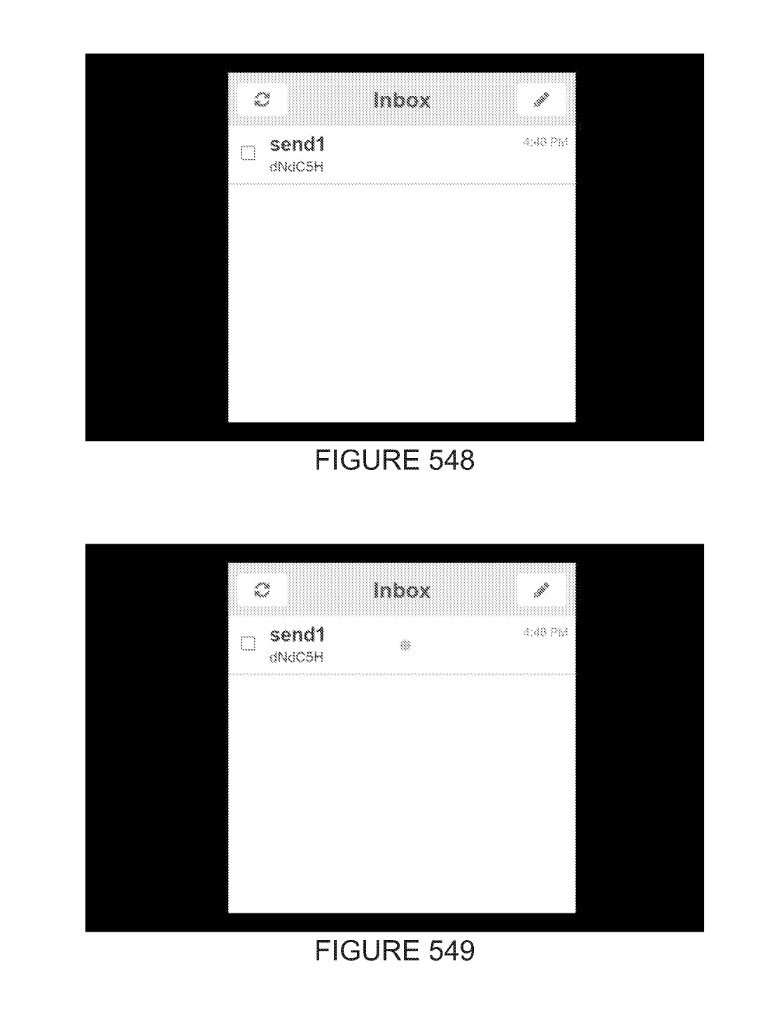

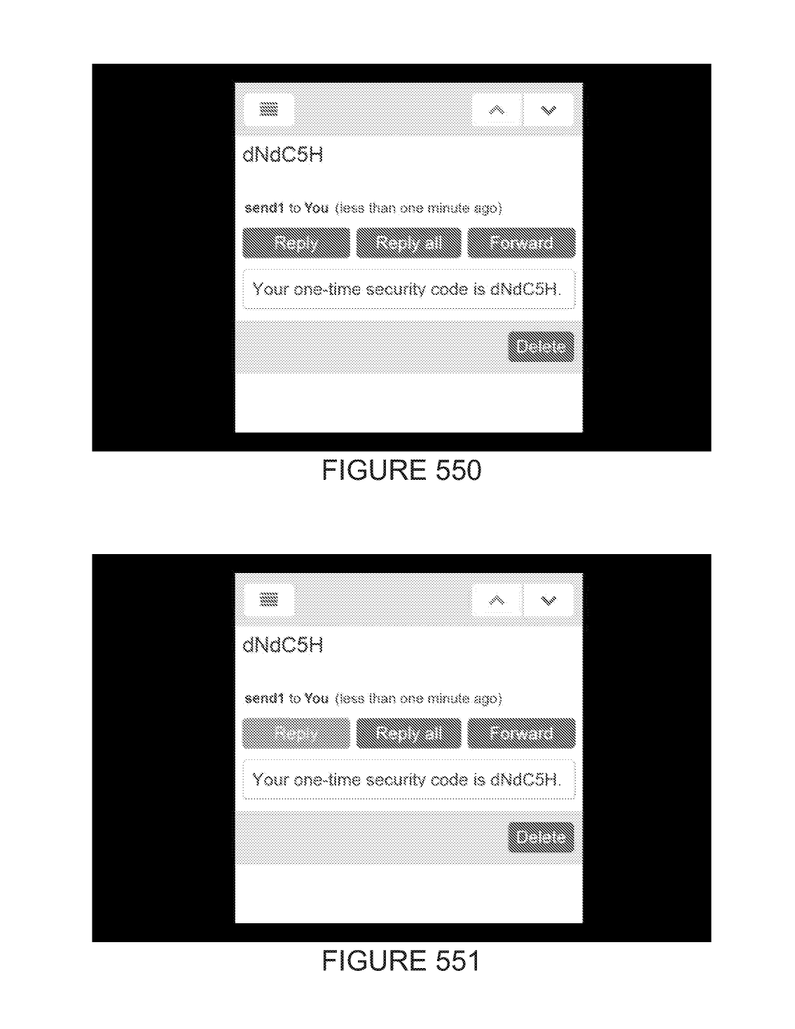

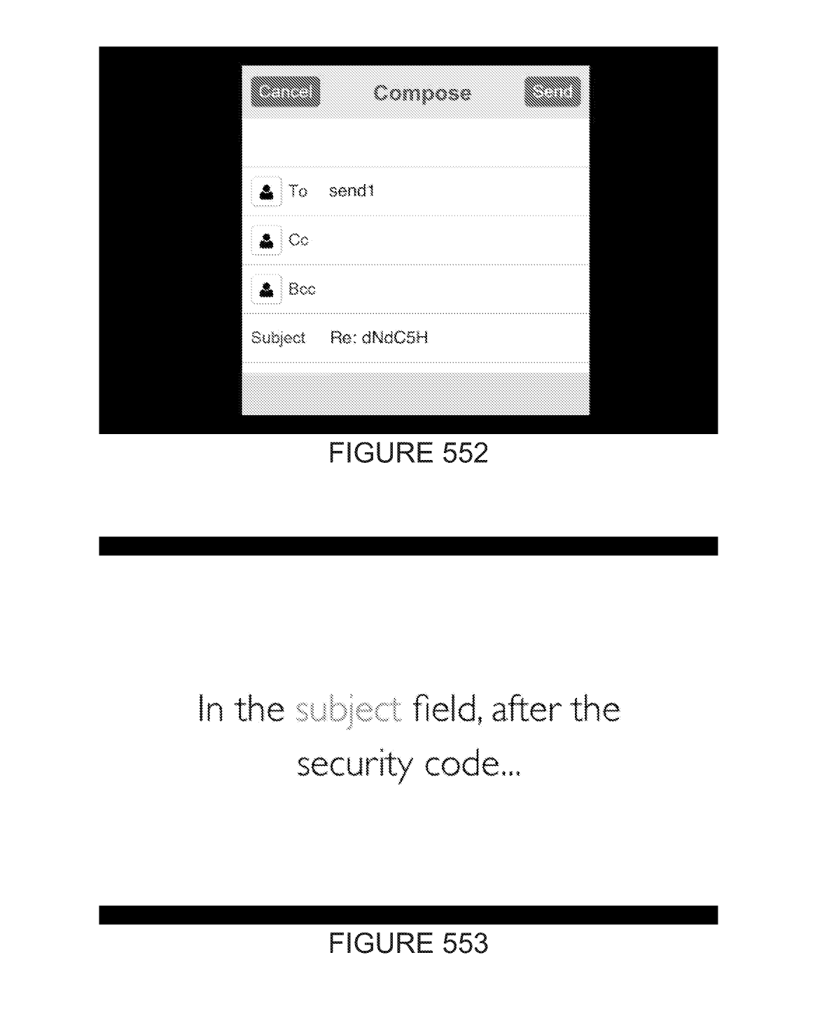

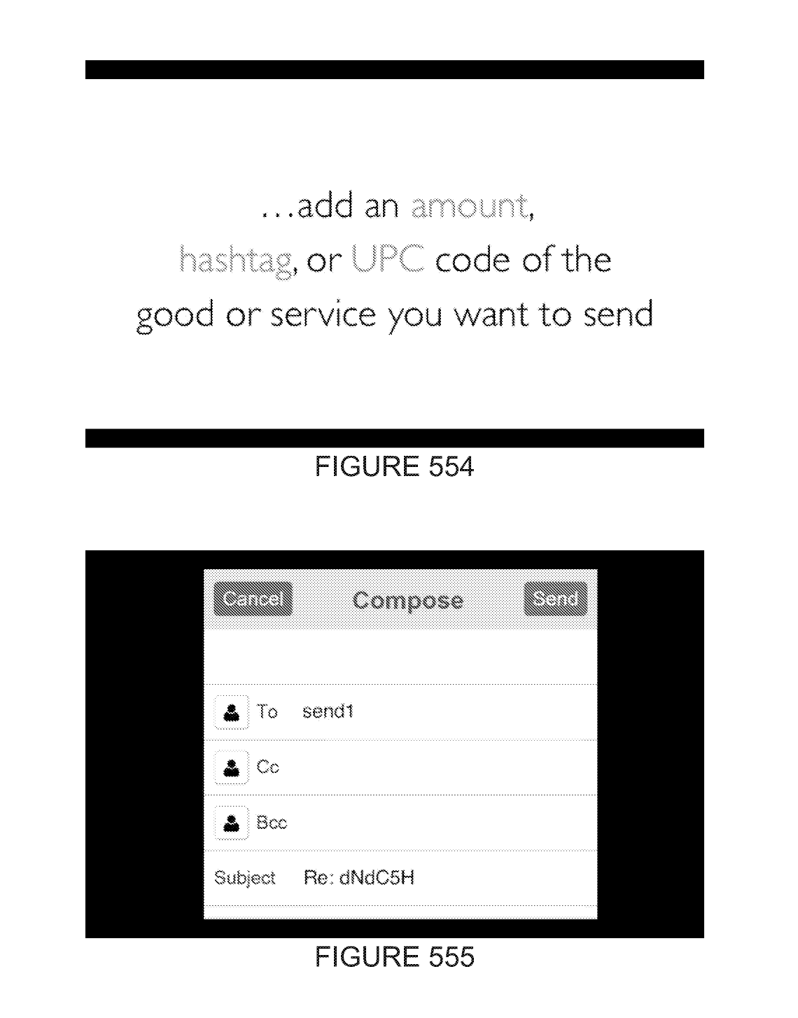

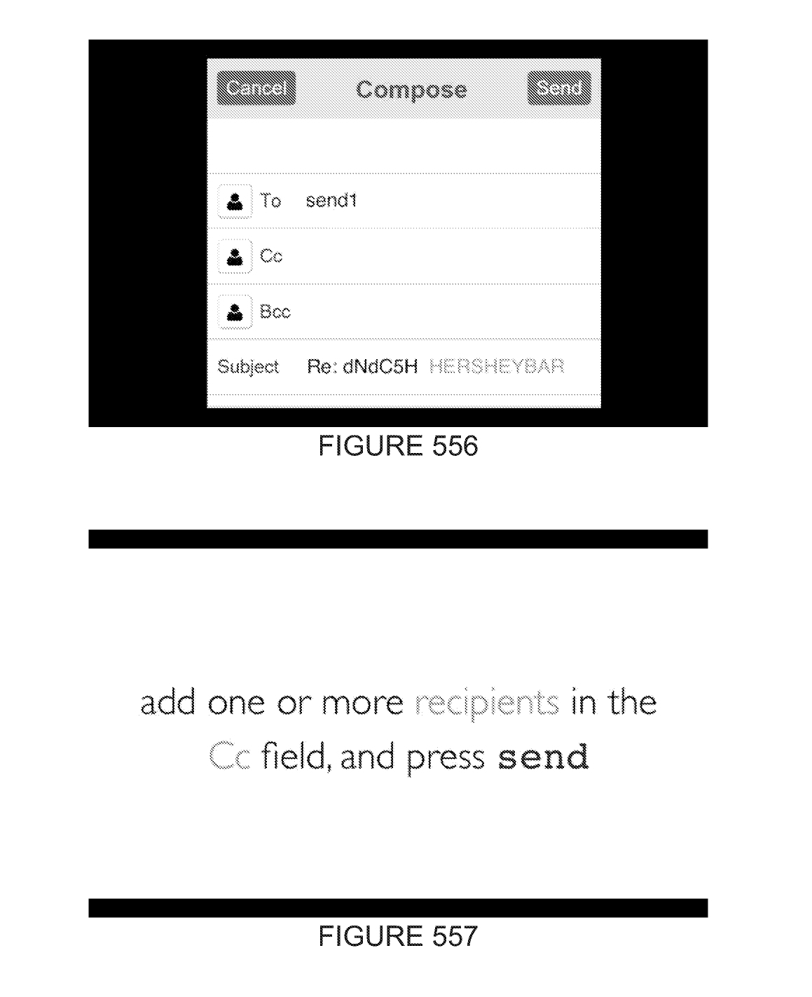

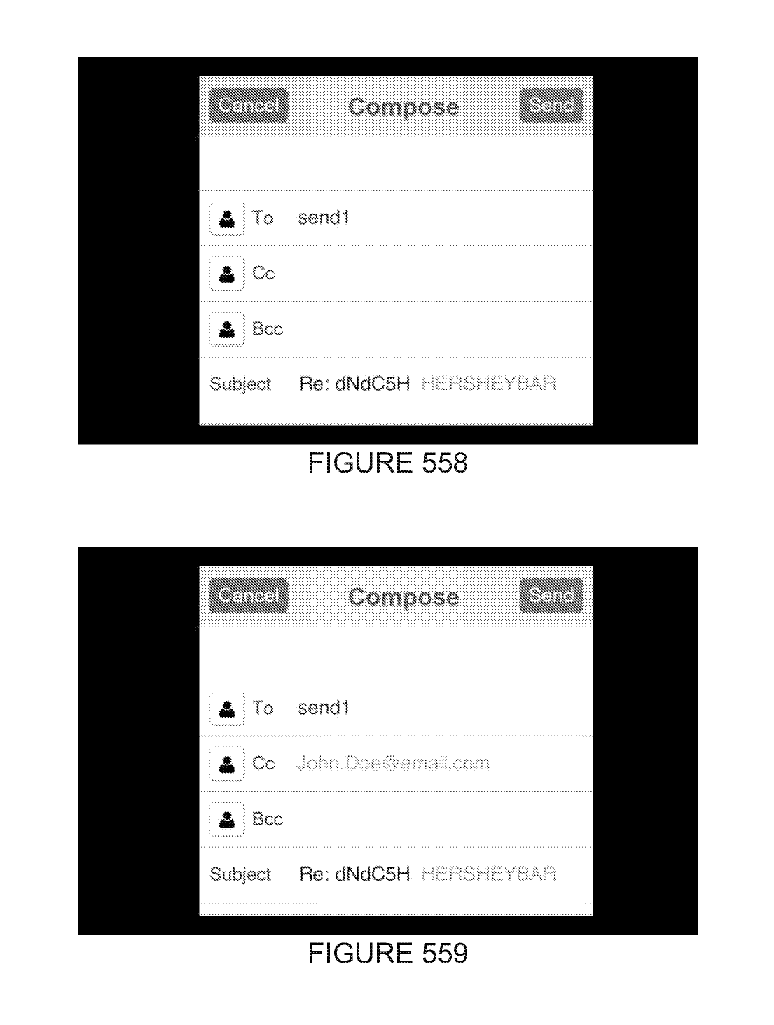

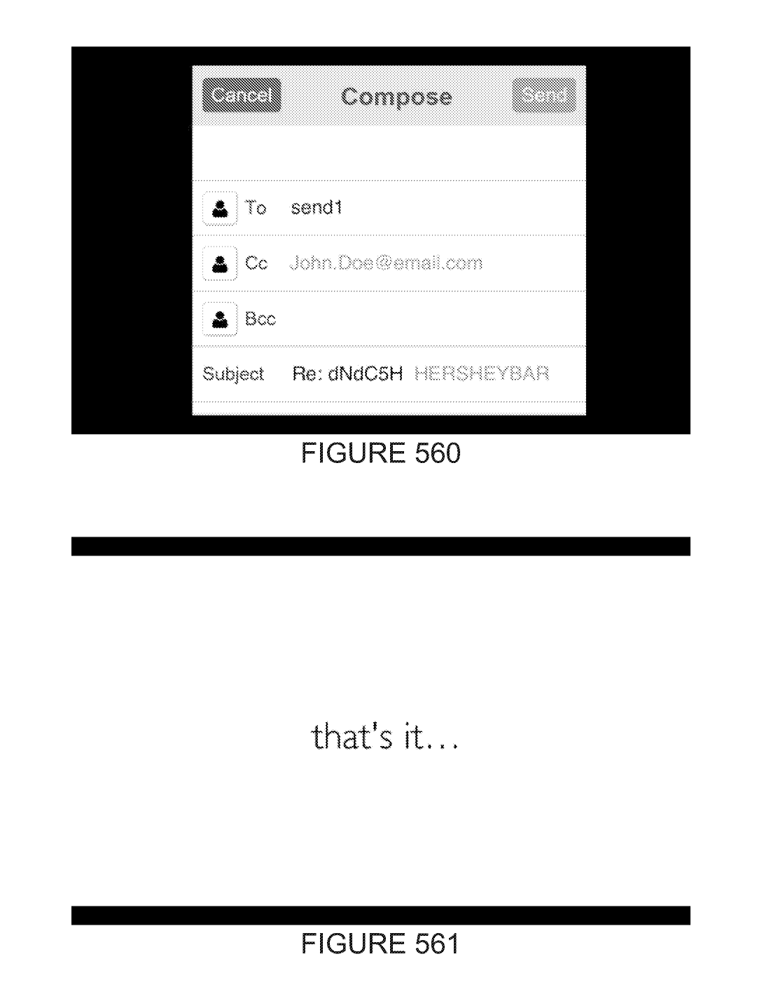

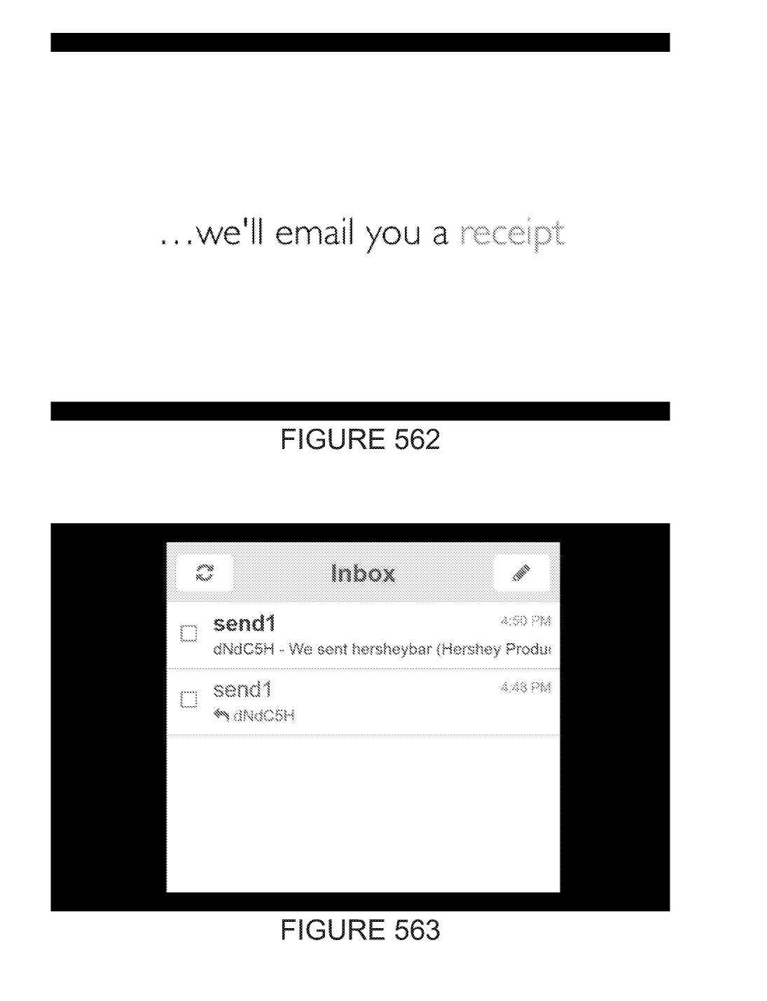

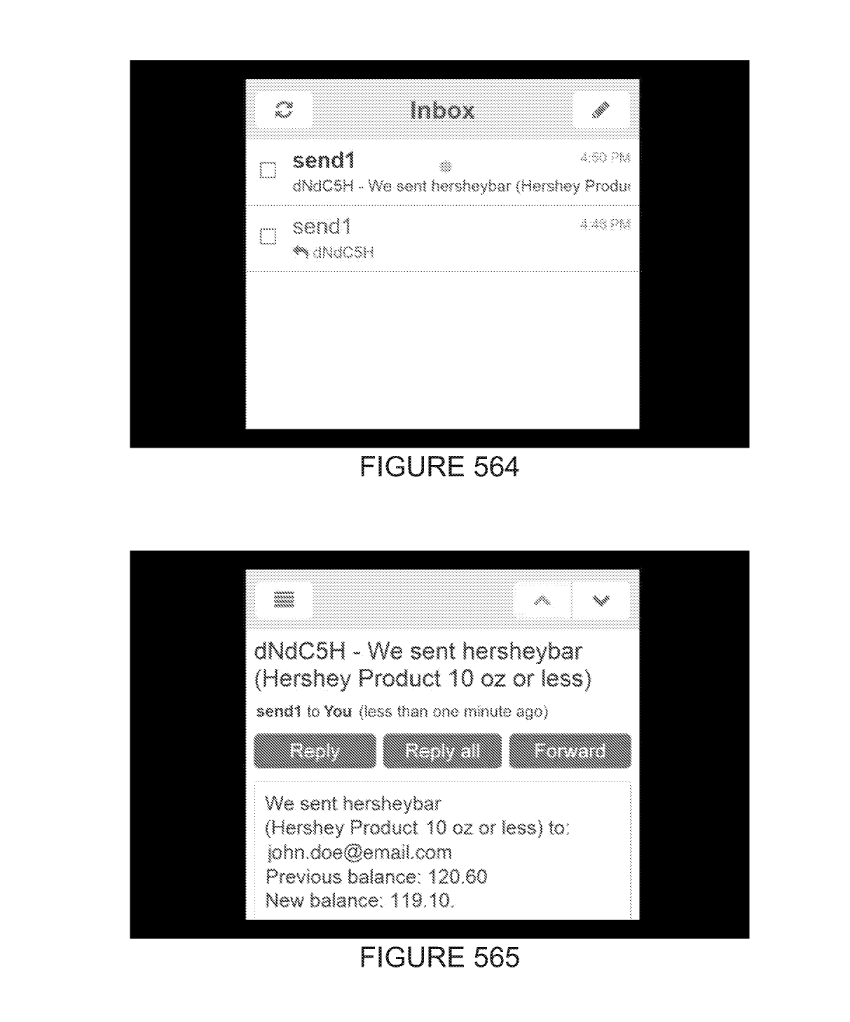

According to some embodiments, a user may utilize system components and/or practice the inventive features and concepts using email communications, without limitation. For example, in some shown embodiments (e.g., non-limiting embodiments shown in FIGS. 330-337 and 539-565), a user may request and receive a one-time verification code from the system, for example, by simply sending the number “1” (one), to a system electronic mail address (e.g., “request@send1now.com”). It should be understood that this number (i.e., the number 1) may be replaced with another instruction, keyword, command, PIN, password, pass code, passphrase, or the like, without limitation. In some embodiments, a user may request a one-time pass code via SMS, and use the one-time pass code instead of the number 1, without limitation (the converse may apply wherein a user may request a one-time pass code via email, and the delivered one-time pass code delivered via email may be used in an SMS-based transaction request communication to a system short code, long code, or the like; and/or one-time pass codes delivered via SMS, social direct messaging, instant messaging, web chat, or email may be used for web-based submissions, without limitation). In some embodiments, card 19 information may be used instead of the number 1, without limitation. As shown, a user may follow the instructions provided in the response email from the system. For example, in the non-limiting embodiments, shown, a user may be instructed to clear the subject, leaving the verification code behind. In some preferred embodiments, the system may parse out any form of “Re:” in the subject line to obviate the need for such a clearing step. A user may then type one or more item codes and/or amounts to be sent, without limitation. This may be done in the subject and/or body fields, without limitation, but for simplicity, embodiments may utilize subject line fields as a matter of convention. In some embodiments, a user may add more than one item code in an email-based transaction request to the system. In some embodiments, a user may add more than one redemption code (e.g., redemption data 64) in an email-based transaction request to the system. In some embodiments, a user may add one or more item codes and/or an amount of credit to be sent in an email-based transaction request to the system. In some embodiments, various combinations of security codes, redemption codes (e.g., redemption data 64), item codes, and/or amounts may be provided in an email-based transaction request to the system. In some embodiments, a user may add more than one amount of credit to be sent (e.g., wherein each amount may pertain to a different form of payment data 10 and may be provided with appropriate identifiers (e.g., 5.00 for system credit, $5.00 for USD, ¥5.00 for Yen, £5.00 for Pounds, Walmart5 for 5 dollars worth of system credit redeemable at Walmart, etc.), without limitation. In this regard, users may consolidate the number of transactions to be made. In some embodiments, sophisticated parsing techniques and other algorithms associated server-side portions of a system application 147 may be employed in such a way that item codes and/or amounts may be provided by users and/or presented within an email-based transaction request, in any order or arrangement. This may also apply for other types of text-based electronic communications made to the system. Moreover, in some embodiments, sophisticated parsing techniques and other algorithms associated server-side portions of a system application 147 may be employed (e.g., using server-side system scripts provided to a host server 128) in such a way that one-time verification codes, item codes, recipient electronic address(es), and/or amounts may be presented in any order, or in any conceivable permutation of placement within the “Subject” and/or “Body” fields, and still process an email-based transaction request correctly (e.g., perform a correct transaction and send correct communications to provided recipient electronic addresses with the correct redemption information), without limitation. However, instructions provided may serve to improve robustness and efficiency of the code used within the system application 147. Parsing and string manipulation techniques may be employed with incoming POST data received by components of the system. Such techniques may utilize character stripping, string length input limits, and/or stripping of certain characters (e.g., commas, parentheses, brackets, periods, single or double quotation marks, question marks, slashes, etc.) to improve security, improve system platform robustness, and/or guard against vulnerabilities such as malicious SQL injections, without limitation.

Turning back to FIGS. 330-337 and 539-565, a recipient may copy recipients (e.g., to the “Cc:” field and/or “To” field, in any number), and add an optional personalized message to the recipients as a greeting, or to disclose the purpose of the transaction, without limitation. In some preferred embodiments, one or more recipients may be added to a transaction request, wherein electronic address information corresponding to the one or more recipients may not be an email address. In such embodiments, recipient information may be placed in the subject line and/or body of the email, without limitation (preferably, using a space, carriage return, underscore, or other separation device). It is anticipated that limits may be applied to the number of recipients which may be copied in an email-based transaction request made to the system, for example, to reduce misuse of the system and/or as a safeguard to users, without limitation. Likewise, in some embodiments, multiple items, products, goods, or services may be liked in the same “like” email-based transaction request, for example, by placing the command “like” (or equivalent) in the subject field and/or the body field, and placing one or more item codes (including GTIN/UPC code numbers) in the subject field and/or the body field, without limitation. Likewise, in some embodiments, multiple recipient electronic addresses which may or may not comprise an email address, may be included in the same “join” email-based transaction request, without limitation. In some embodiments, if a friend to be joined comprises an email address, it may be placed in the “Cc:” field and/or in the “To:” field, without limitation. Likewise, in some embodiments, multiple electronic addresses may be included in the same “link” email-based transaction request, wherein one or more separate communications containing one or more separate and unique validation codes may be sent to the requesting user, wherein each of the one or more separate and unique validation codes may be sent to and/or used with the respective electronic address platform (e.g., phone, email, social media, etc.). In some embodiments, a single validation code may be sent the requesting user, wherein the same validation code may be used on each of the respective electronic address platforms being “linked”, without limitation. Other functions described herein may be facilitated through email-based transaction requests to the system, without limitation, and may similarly allow pluralities of data types; however, as with the number of recipients of items and/or credits, there may be theoretical limits or rules imposed by the system regarding the number of item codes and/or link addresses which may be allowed to be sent in a single transaction (e.g., there may be possible limitations on text message character lengths for SMS, or for social media sites like Twitter, service provider limitations, participating entity 65 restrictions, etc.). Once an email-based request transaction has been drafted, the user may then press send to deliver the instruction(s) to the system, so that the system can perform the necessary outputs 5, without limitation.

In some instances, duplicate recipients may be neglected or otherwise ignored by system processing software 147, for example, to prevent duplicate/redundant “sends”. In some embodiments, a user may be limited to the number of transactions made to a particular user within a predetermined time period, without limitation. Restrictions or limitations on the number of email-based transaction requests may be time-based, for example, to ensure that enough time has passed for the required push/pull functions to take place, and/or to ensure that the sender's and/or recipient's cellular carriers and/or email client/host servers have had enough time to process, send, and/or deliver the electronic messages or relevant electronic data communications. This may, for example, reduce duplicate send requests due to low connectivity, slow network service, or no-service scenarios, which may cause complications in the form of delayed requests being redundantly processed later. In this regard, in some embodiments, a user may send one transaction request, and have to wait a specified period of time before sending another transaction request to allow time for the transaction to process. Instructions may state this, and/or provide a guideline for wait times, without limitation. Impatient sending users may be tempted to send the same transaction request multiple times if the recipient does not receive their redemption immediately due to carrier delays; and/or impatient sending users may be tempted to send the same transaction request multiple times if the recipient does not immediately confirm or acknowledge a receipt of redemption information 64 from the system. In some embodiments, limits on transaction frequency limits may be applied, without limitation, to the number of transactions made to the same (or similar) recipient(s) within a specified period of time, the number of transactions made using the same (or similar) item code(s) within a specified period of time, and/or the number of transactions made using the same (or similar) amount(s) of credit. In some embodiments, limits on transaction frequency may be limited to transaction requests made from electronic addresses suspected of suspicious or fraudulent activity or otherwise previously reported, without limitation.

In some embodiments, recipients may receive your original request message, and a subsequent message from the system. If one-time verification codes are utilized, the verification codes should match, thereby providing a readily-identifiable security feature, without limitation. For example, as may be appreciated from FIG. 18 of co-pending U.S. Provisional Patent Application No. 62/009,149, a one-time verification code such as “MmcNvo” may be utilized. One-time verification codes may contain any combination of upper and lowercase alphabetic characters, numeric characters, and/or symbols, without limitation, for example, for increased security and/or smaller probabilities of malicious guesswork.

Recipients may decide return the favor, for example, to say “thank you”, by sending a new transaction request to the system via system components. Recipients may also decide to re-gift, cash, or trade received redemption information 64, without limitation. In some embodiments, re-gifting may comprise typing, saying, or otherwise providing information pertaining to unused redemption information (e.g., a redemption code and/or redemption PIN) instead of an item code or amount to be sent, without limitation.

It is envisaged that in some embodiments, a “gift” command may be utilized, in combination with a recipient's electronic address and a redemption code to be re-gifted. The “gift” command may suggest that the transaction is meant to re-gift the received redemption information 64 pertaining to funds or credits, or the received redemption information 64 pertaining to an item, product, gift, or service. However, such a “gift” command may not be entirely necessary. In more preferred working embodiments, redemption information (e.g., a redemption code) may replace or be used in lieu of an item code or amount to be sent, and/or wherein the transaction communication may be formatted and sent similar to a convention utilized for other transaction request communications, without limitation (e.g., a “[recipient's electronic address(es)] [item code or amount to be sent]” or “[item code or amount to be sent] [recipient's electronic address(es)]” convention may be used for re-gifting: “[recipients electronic address(es)] [redemption code to be sent]” or “[redemption code to be sent] [recipient's electronic address(es)]”). The exact order of commands may be predetermined, or the system scripts interpreting incoming transaction request communications may be made robust enough to allow different orders for commands.

In some embodiments, a user may send a plurality of his/her friends, coworkers, and/or family at the same time, without limitation. As shown in the non-limiting embodiments shown in the figures, multiple recipients may be attached to a single transaction request communications to the system. Transaction request communications may comprise multiple social media handle addresses, multiple email addresses, multiple phone numbers, and/or various combinations thereof, without limitation. In some instances, transactions may be split up into “feed” type communications that are sent in piecemeal. For example, as shown in co-pending applications, system components may send subsequent communications prompting the user for information in small bits and pieces. For example, system components may send a first message asking for first user input(s) 4 comprising information regarding the item or amount to be sent, for example, without limitation: “Reply ‘C’ to send credit, or reply ‘I’ to send an item.” For example, system components may send a second message asking for second user input(s) 4 comprising information regarding, the item or amount to be sent, for example, without limitation: “Reply with the amount to be sent.”, or “Reply with the item to be sent”, and so on and so forth. Other subsequent third, fourth, fifth, etc. messages asking for respective third, fourth, fifth, etc. user inputs 4 may be sent, for example, without limitation: “Would you like to add an item? Reply ‘Y’ for yes, or ‘N’ for no.”, “Reply ‘E’ to send to an email address, ‘P’ to send to a mobile phone number, ‘T’ to send to a Twitter user, or ‘F’ to send to a facebook profile ID.”, “Please enter the recipient's phone number now”, “Please verify, you wish to send PRODUCTX to person@email.net at the cost of 2.34. Reply ‘Y’ to approve transaction, or ‘N’ to cancel.”, “Reply ‘STOP’ if you wish to stop receiving messages”, combinations thereof, and/or the like.

In some non-limiting, but preferred embodiments, if a recipient doesn't have an account with the system (e.g., a system database 129 does not recognize a user-provided recipient electronic address and/or a user-provided recipient physical address) a new account may be created for them by system components 118, 128, 129, 147, for example, automatically, without further action by the recipient, without limitation.

A neat feature, according to certain embodiments, is that recipients may not need to jump through too many hoops in order to be able to begin use of the inventive features and concepts, such as to be able to redeem credit or prepaid items, re-gift received items, and/or purchase something immediately with a vehicle as simple and easy as a text or email. The system may create a basic account using the information provided by the sending user making the transaction request. The recipient may later purchase credit and/or link their other electronic accounts (e.g., using a system “link” command or the like; for example by providing the word “link” in an electronic communication to the system or system component (e.g., a system-integrated server) with another electronic address of the recipient. A user may, in some embodiments, top off their account balances or add credit; for example, by purchasing a new system card 19 (e.g., a “ShareCard” prepaid card) and/or purchasing credit electronically (e.g., online, via the system website 127, or third party website affiliated with the system which may comprise system software 147). In some embodiments, if a new card 19 is purchased and activated by a user 91 of the system, credit from their existing system account(s) may be consolidated using the link command (e.g., providing the link command and information from one or more cards 19 or system-recognized electronic addresses within a system database 129). Card information provided with a link command, may, for example, contain one or more card PINs, function codes, account numbers, and/or the like, without limitation. After a new card 19 is purchased, the user may be assigned the respective new card 19 number in the system database, wherein previous card 19 numbers and/or previous PINs may be retired upon activation of the new card 19. In some embodiments, multiple user accounts may be kept (e.g., for different electronic addresses), wherein each user account may have separate and unique balances, card 19 numbers, and/or card PINs, which may be associated with the same person (e.g., multiple accounts may be associated with different electronic addresses of a user, each of the different electronic addresses belonging to the same user), without limitation. In such latter embodiments, a person may, in some embodiments, utilize separate unlinked accounts, for example, an account for use with email, an account for use with their social media profile, and/or an account for use with their mobile device, without limitation. In some embodiments, a user may link accounts using a system command, for example the “link” command. A user may provide the one or more card 19 numbers affiliated with their account in combination with the “link” command in a communication to the system (e.g., to a system server or server integrated with the system as a whole), for example, as a security measure (e.g., a pass code, password, PIN, or the like), or to link accounts associated with the card 19 information, without limitation. Follow-up instructions may be provided to system components from users 91, 92, and/or follow-up instructions may be provided from system components to users 91, 92, without limitation.

In some non-limiting embodiments, received funds or credits (e.g., redemption data 64) may be used immediately by a user, without limitation. In some embodiments, if system credit is transferred the funds may be sent and/or used to make purchases and/or payment. In some embodiments, if non-system credit is transferred from a first user 91 to a second user 92, and user data 8 associated with the second user's 92 profile 130 and/or the first user's 91 profile 130 contains non-system account 48 information (e.g., such as a third-party account 48 information or financial institution 163 account 48 information), then payment may be delayed for a holding period, without limitation.

In some embodiments, an electronic address validation process and associated steps comprising user input 4 (e.g., a phone validation or email validation) may be required. For example, in some embodiments, a recipient 92 of funds or credits in one or more forms or types 72 may confirm that their email address is valid and active. This may be accomplished, for example, by system components 118, 128, 129, 147 generating, storing, and sending a one-time validation code to the recipient 92 (e.g., to an email inbox or phone inbox (e.g., voicemail, SMS, mobile message, and/or the like, without limitation). In some embodiments, the one-time validation code sent by system components may be included in the same communication as a communication that contains the redemption information 64, without limitation. In some embodiments, the one-time validation code sent by system components may be included in a communication which is a separate and distinct communication from a communication that contains the redemption information 64, without limitation. In some embodiments, accounts may be created for recipients that receive funds, such as system credit or credit in another tangible form of payment data 10, for example, in a form which may comprise redemption information 64 and/or further instructions on how to use/redeem the received funds, without limitation. In some embodiments, accounts may be created for recipients 92 that receive redemption information 64 (e.g., one or more redemption codes which may be exchanged for one or more pre-paid items, products, physical gifts, electronic gifts, goods, and/or services), without limitation. For example, in some embodiments, accounts may automatically be created by system components 128, 129, 147, for non-system members who may receive funds and/or credit(s) (e.g., credits comprising system credit, payment data 10, redemption codes for pre-paid items, products, gifts, or services, and/or the like), without limitation. In some embodiments, a received one-time validation code may be sent back to the system in one or more electronic communications, which may be web-submission-based and/or electronic message-based, without limitation. In some embodiments, a received one-time validation code may be sent back to the system, using the same respective platform or communications protocol used to receive the one-time validation code (e.g., in an email to the system if the one-time validation code was received in an email from the system, in a phone call to the system if the one-time validation code was received in a phone call from the system, in a mobile message to the system if the one-time validation code was received in a mobile message from the system, in an SMS message to the system if the one-time validation code was received in an SMS message from the system, in an MMS message to the system if the one-time validation code was received in an MMS message from the system, in a social media direct message to the system if the one-time validation code was received in a social media direct message from the system, in a social media post to the system if the one-time validation code was received via a social media post from the system, etc), without limitation. In some embodiments, a received one-time validation code may be sent back to the system, using a different platform than the platform or communications protocol used to receive the one-time validation code, without limitation. System components 95, 128, 147 may check to verify that an incoming electronic address matches an electronic address in one or more of its databases 129. System components 95, 128, 147 may check to verify that an incoming electronic address matches an electronic address in one or more of its databases 129 and may check to verify that a received one-time validation code communicated to the system from the incoming electronic address is affiliated with the incoming electronic address in one or more of its databases 129; for example, to validate and/or authenticate transaction requests, without limitation. If a user's incoming electronic address (e.g., being identifiable from header information, being identifiable from an incoming “From” field in a $_POST data array, being identifiable from caller ID provisions, being identifiable from an incoming “From” field in an email header, being identifiable from incoming “From” information associated with a social post, or the like, without limitation) matches a validation code (e.g., one-time validation code) in a system database 129, the respective user's account may be activated, without limitation. Similar practices may be employed for activation of accounts, updates to user preferences 63, and/or to perform various inventive functions described herein, without limitation. In other, simpler embodiments, no validation steps may be required, without limitation, wherein system components may create a user account based on incoming electronic address information only, and/or may accept transaction requests involving the incoming address information only. In some embodiments, system credit may be debited and/or credited to accounts 48 and/or profiles 130 as necessary to complete transaction requests (e.g., in real-time or at a time in the future, for example, upon future use/redemption of redemption information 64), without limitation.

According to some embodiments, the inventive technology, its components, features, and/or concepts, may provide a simple and/or convenient way to send money, transfer funds, deliver credit(s), transfer credit(s), order things, deliver things, make payments, sign up for events, request information regarding items, products, goods, and services, add things to wish lists, gift lists, and/or shopping lists, as well as perform various social functions—including, but not limited to social commerce functions. According to some non-limiting embodiments, the system, methods, and apparatus thereof described may provide the under banked or un-banked, as well as individuals possessing non-sophisticated/low-tech/minimalistic mobile devices (e.g., re-loadable prepaid or “burner” phones), the ability to perform various transactions, such as mobile commerce transactions, conveniently and quickly, for example, in situations where access to Wi-Fi is limited, in situations where there are weak data connections or signals, and/or in situations where an expensive carrier data plan is not utilized, without limitation. According to some embodiments, users may check their balance at any time, for example, through mobile application 147 interactions with a user interface 106 of a mobile device, or by using a system “balance” command or equivalent instruction keyword. For example, a system balance command may comprise, without limitation, “B”, “b”, “Bal”, “bal”, “bAl”, “balance”, combinations thereof, and/or equivalents thereof, or the like, without limitation. A balance command may be provided in an electronic communication to the system, via a system electronic address to receive profile 130 information from a system database 129, such as balance information of one or more accounts 48 associated with a respective user profile 130. A system-integrated server 128 may comprise a script 147 containing an algorithm which may process the command and which may execute an output 5, such as a desired function to be performed or an execution pertaining to the command provided to the system. According to some embodiments, an electronic message may be sent from an electronic address of the system, to a user 91 or participating entity 65 electronic address, via the same platform used by a user 91 or participating entity 65 to deliver a transaction request communication to the system, without limitation. According to some embodiments, an electronic message may be sent from an electronic address of the system, to a user 91 or participating entity 65 electronic address, via a different platform than a platform used by a user 91 or participating entity 65 to deliver a transaction request communication to the system, without limitation. According to some embodiments, an electronic message sent from an electronic address of the system, to a user 91 or participating entity 65 electronic address may indicate a user's current system credit balance, for example, if the system receives a “balance” request in a transaction request communication from a user 91 or participating entity 65 electronic address, without limitation. Similar balance inquiries may be performed through interactions with and/or input(s) 4 to a user interface 106 or browser 131 provided to a system application 147 or website 127, without limitation. According to some embodiments, the inventive technology, its components, features, and/or concepts, may provide a simple and/or convenient way to register and/or pay for events, sign up for clubs or mailing lists, enter sweepstakes, and/or the like. Moreover components of the inventive platform(s) provide a simple and/or convenient way to send gifts, order things (e.g., items, products, goods, or services), deliver things (e.g., items, products, goods, or services), and/or the like, without limitation.

According to some embodiments, a user may walk into a store, approach a kiosk 3 or payment terminal, and purchase system credit, or a user may purchase system credit online. The purchased system credit may be linked with one or more of the user's electronic addresses upon an activation step after purchase, during purchase, or before purchase, without limitation. According to some embodiments, a user may shop or browse an electronic commerce platform (e.g., a system website 127, participating entity 65 website, and/or mobile application 147) to find a product, item, good, or service to buy, gift, like, wish, recommend, or the like, without limitation. Upon identifying a product, item, good, or service of interest, the user may engage a system-affiliated widget (e.g., an, icon, link, word, image, picture, or the like (e.g., “button”)), for example, a widget which may be powered by a system API or browser 131 add-on. The widget may preferably be placed adjacent to indicia representative of the product, item, good, or service of interest on a page of the website or mobile application's user interface 106 display. Alternatively, the widget may be a single button displayed on the page or display. Alternatively, the widget may be a browser button (e.g., “toolbar button”) which may be operably engaged upon identifying and selecting a product, item, good, or service of interest. Upon widget interaction, a pop-up or other window or page may be displayed, wherein the pop-up or other window or page may contain a mini user interface 106, a subset of the web page, and/or a new user interface 106 page (e.g., if using a mobile application 147), without limitation. In some embodiments, the pop-up or other window or page may contain instructions (e.g., such as a system item code information, cost information, and/or the like, which may pertain to the product, item, good, or service of interest). In some embodiments, the user may provide one or more physical and/or one or more electronic addresses (including user electronic addresses and recipient addresses, without limitation) to the pop-up or other window or page (e.g., via the browser 131 used to shop the electronic commerce platform). In some embodiments, the user may provide one or more physical and/or one or more electronic addresses (including user electronic addresses and recipient addresses, without limitation) to a system electronic address through another platform (e.g., text messaging, mobile messaging, social media, email, phone, or the like), in order to purchase, gift, like, wish, recommend, and/or request the product, item, good, or service of interest (e.g., which is displayed on the browser 131 supporting a web page of the electronic commerce platform being browsed). In some embodiments, one or more portions of instructions (e.g., such as system item code information, cost information, and/or the like, which may pertain to the product, item, good, or service of interest) provided on the page or display of the browser, may be used in an electronic transaction request communication which may be delivered to a system electronic address. A system-affiliated API or add-on may receive the user input 4, and the input 4 may be communicated with a system server 128, for example, to exchange information with database 129 containing profile information 130 of the user, without limitation. One or more system components (e.g., system software 147 provided to the server 128) may deliver, via network 118, one or more electronic communications to the user and/or to one or more intended recipients of the user (e.g., intended recipients chosen by the user), based on the platform/protocol associated with the one or more electronic addresses provided. For example, if one or more recipient email addresses are provided by the user as an input 4, the system may deliver redemption information 64 to the one or more recipient email addresses, via an email protocol (e.g., POP3, SMTP, or the like). In some embodiments, the system may associate information relating to the product, item, good, or service of interest with one or more one-time PINs or passwords which may be delivered to the user and/or the intended recipient(s). The system may request, and the user (and/or recipient(s)) may provide one or more reply inputs 4 (e.g. one or more reply communications to the system) in order to facilitate the transaction (which may include physical delivery of the product, item, good, or service of interest, electronic delivery of redemption information 64 associated with the product, item, good, or service of interest, and/or receipt information 20 regarding the same, without limitation). In some embodiments, more than two different platforms/protocols may be associated with the transaction (e.g., different platforms for front-end requests, and back-end delivery of redemption information 64 and/or receipt information), as illustrated.

In some embodiments, a point of sale may be attended by a store employee (e.g., in instances where a participating entity 65 has a physical venue/location 2, such as a brick-and-mortar facility, without limitation. In some embodiments, the point of sale may be an online shopping website or mobile commerce shopping page on an electronic commerce platform website. In some embodiments, the point of sale may comprise a kiosk 3 (e.g., an ATM, vending machine, a self-operated machine configured with a user interface 147, a soda/snack machine, and/or other type of system or non-system-affiliated kiosk e.g., a Coinstar brand machine or a Redbox brand machine, etc.), without limitation.

In some embodiments, a recipient electronic address may belong to an entity 65 or individual 91, 92 associated with the electronic address. A recipient electronic address may be a personal electronic address, without limitation. In some embodiments, a recipient electronic address may be the same as, or may comprise a personal electronic address of a sending user 91, for instance, when one or more purchasable products, items, goods, or services are desired to be purchased by, liked by, wished by, requested by, recommended by, and/or sent to themselves, instead of being sent to another entity, without limitation.

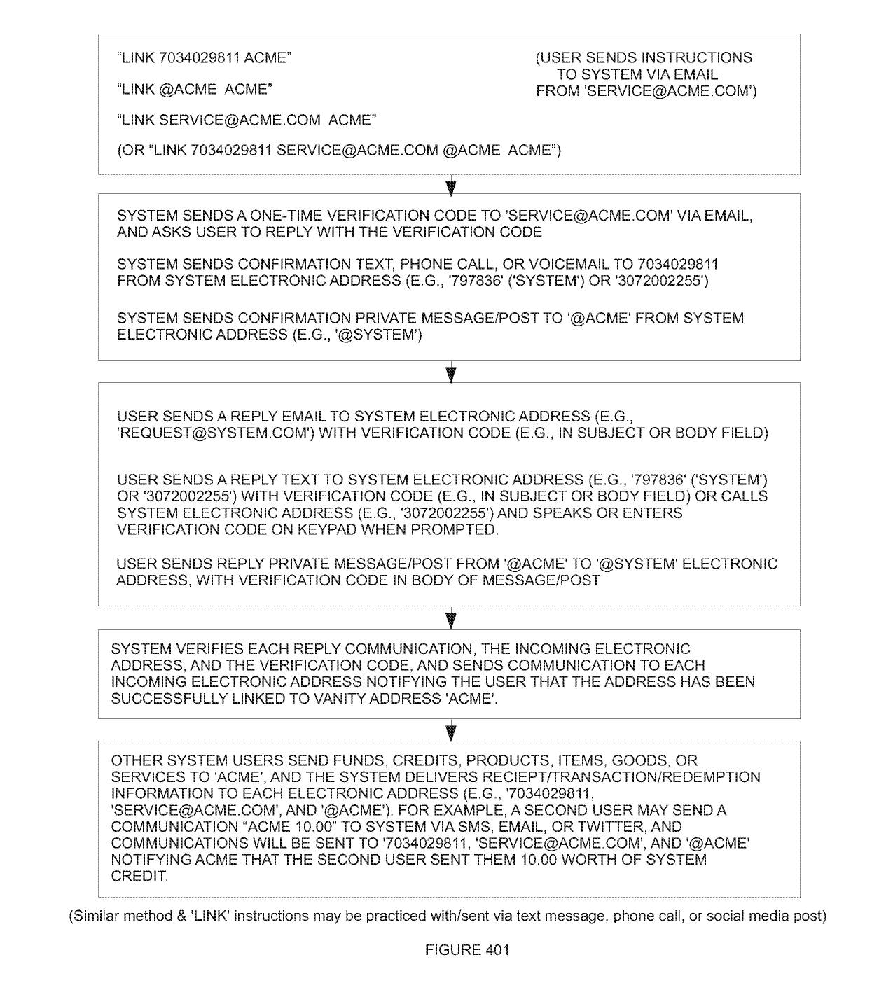

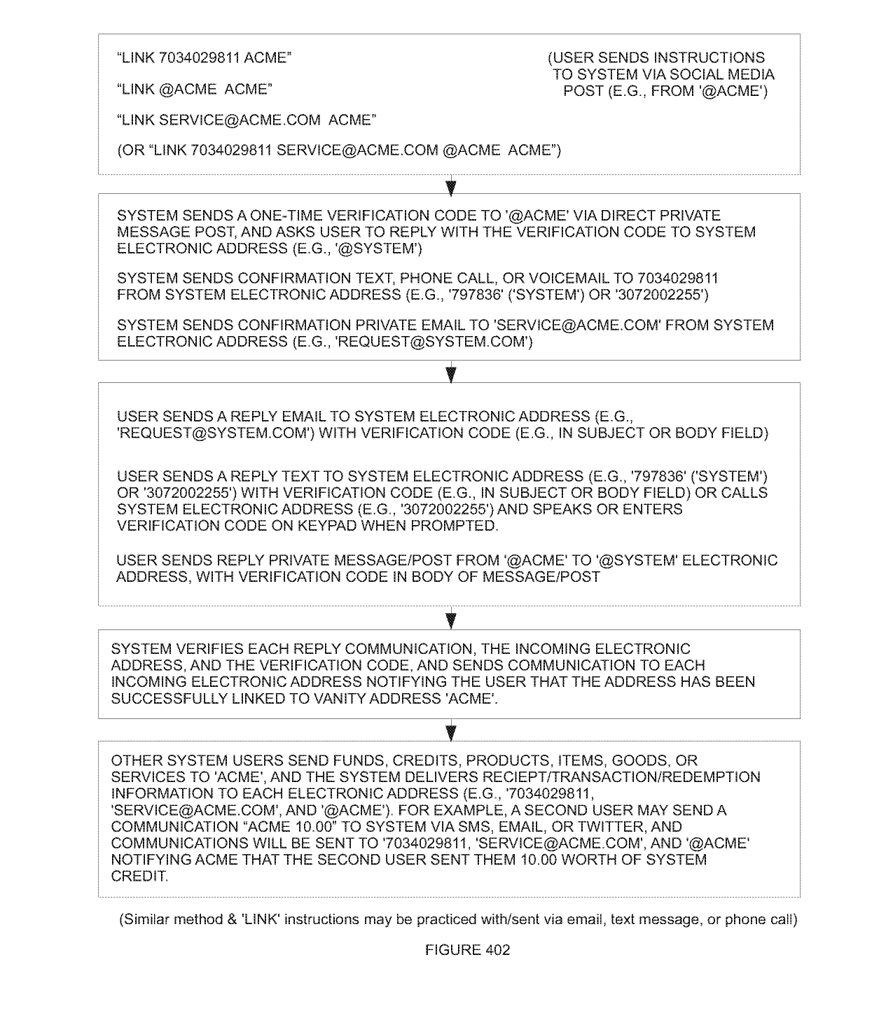

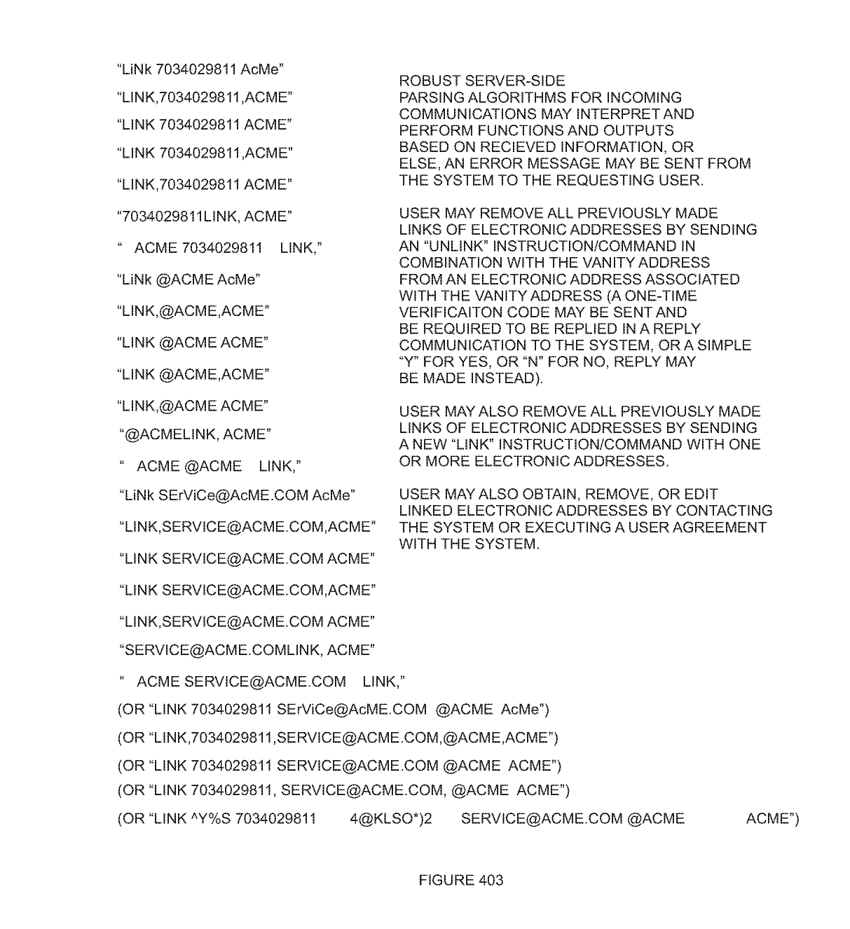

According to some embodiments, a recipient electronic address may comprise a system ‘vanity’ address. According to some embodiments, the system vanity address may be affiliated with one or more electronic addresses associated with one or more individuals and/or one or more entities 65, without limitation. As suggested in the figures, particularly FIGS. 401-406, a user may link one or more system electronic addresses to a ‘vanity’ system address, to simplify future transactions using inventive system methods and features described herein, without limitation.

In some embodiments, a user may walk into a store, approach a kiosk, machine 95 comprising a CPU provided with a user interface, and/or a payment terminal having access to system components 128, 129, 147 via network 118, and purchase system credit. In some embodiments, a user 92 may receive credit from another user 91 (wherein a system account may be created for them prior to receipt of the credit from another), and the user 92 may then purchase a system card 19, may activate it, may associate the system card 19 to one or more of the user's 92 electronic addresses, and the system may combine any credit associated with the purchased system card 19 with the credit received from the another user 91. In some embodiments, a user 91 may purchase credit online as discussed herein and in the abovementioned co-pending applications. In some embodiments, a user 91 may purchase system credit via the user's 91 financial institution 163 profile 130′, for example, when the user 91 is logged into his/her online banking web site (e.g., an HTTPS web page), and may transfer funds into their system account via system software 147, through the financial institution website, without limitation. In some embodiments, a user may approach a checkout terminal, ask an employee manning the checkout terminal to purchase an amount of system credit for him/herself (and/or for one or more other users), pay for it normally (using cash, credit card, gift card, voucher, EBT card, or the like), provide one or more his/her electronic addresses (e.g., phone number, email address, Twitter address/handle, or the like) to the employee (or, provide one or more his/her friend's electronic addresses), and then digitally/electronically receive the system credit after the employee sends an electronic communication to the system indicating both the desired amount of system credit purchased and the user-provided electronic address(es) (i.e., the user's electronic address). In this scenario, if the user provides one or more electronic addresses of others, the one or more other electronic addresses may receive the system credit after the employee sends an electronic communication to the system indicating both the desired amount of system credit purchased and the user-provided electronic address(es). The user may then shop or browse an electronic commerce platform (e.g., participating entity 65 website or mobile application) to find a product, item, good, or service for gifting or purchasing (e.g., in physical stores and/or on electronic commerce websites). The user may, for instance, engage a website checkout page, which may be powered by a system API, a browser add-on/app, or the like 147. The user may provide information to the electronic commerce platform, such as user information 8 (e.g., one or more physical or electronic addresses, one-time codes, transaction codes, validation codes, system card numbers, system PIN numbers, combinations thereof, and/or the like), via the browsed electronic commerce platform (e.g., the user may provide information via one or more fields provided to a checkout page component of the website or mobile application), and/or may provide information, such as information received (previously received or received in real time) from the system or from another user(s) through another platform (e.g., text messaging, mobile messaging, social media, email, phone, or the like), to the electronic commerce platform, via the browsed electronic commerce platform, in order to facilitate the purchase of a product, item, good, or service of interest, which may be displayed on the electronic commerce platform component, and/or the delivery of redemption information to one or more intended recipients. According to some embodiments, the system-affiliated API, browser add-on/app, and/or the like may receive user inputs 4, and may deliver one or more electronic communications to the user, and/or receive one or more electronic communications from the user to the system, based on inputs 4 received, without limitation.

In some non-limiting embodiments, no fields may be provided to a component of the electronic commerce platform (e.g., no fields may be provided to the checkout page of a participating entity 65 website or mobile application), and instructions and/or one or more pieces of information may be displayed on the checkout page, for example, to guide a user who is checking out, in a way that the user may purchase the respective items, products, goods, or services associated with a component of the electronic commerce platform (e.g., in a checkout cart), without entering information online via the electronic commerce platform component (e.g., checkout page). In some non-limiting embodiments, one or more fields may be provided to an electronic commerce platform component (e.g., checkout page), and instructions and/or one or more pieces of information may be displayed via the electronic commerce platform component (e.g., displayed on the checkout page), in order to guide a user who is checking out, in a way that the user may purchase the respective items, products, goods, or services associated with a component of the electronic commerce platform (e.g., in a checkout cart), by entering information both online via the via the electronic commerce platform component (e.g., checkout page), and through another platform (e.g., email, text messaging, phone call, or social media), without limitation.

While the specific embodiments have been illustrated and described, numerous modifications come to mind without significantly departing from the spirit of the invention, and the scope of protection is only limited by the scope of the accompanying claims and/or claims of applications which are related to this application. One skilled in the relevant art will appreciate that the inventive concepts disclosed can be used in various environments other than what may be shown (e.g., SMS/MMS messaging protocol environments, mobile messaging protocol environments, electronic mail environments, mobile application-based environments, service provider networks, the Internet or web environments, chat environments (e.g., IRC), Trillion environments, instant messaging environments, etc.). In general, display descriptions may be in WPF format, HTML format, email format, or any other format suitable for displaying information (including character/code-based formats, algorithm-based formats (e.g., vector generated), and bitmapped formats).

Various communication channels may be used as a portion of system network 118, such as a local area network, wide area network, or a point-to-point (P2P) dial-up connection instead of the Internet. The system and subcomponents thereof may comprise any combination of devices, hardware, and software (inclusive of system-proprietary, system-integrated, and purely third-party devices, hardware, and software) that can support these inventive concepts. For example, a web server (e.g., system server 128 and/or other networked or system-integrated server) may include multiple computers and/or series of server devices which may be networked together, without limitation. “Cloud” computing structures may be implemented, and it is foreseen that cloud computing structures may comprise one or more system-integrated servers 122, 128, 136, or that one or more system-integrated servers 122, 128, 136 may conversely comprise cloud computing structures. The system may comprise any combination of devices, hardware, and software that interacts with the system server(s) 128, participating entity server(s) 136, financial server(s) 122, or other external server(s) 125, as well as other components of the system described herein (e.g., kiosks 3, mobile devices 96, system platforms, websites including third-party, system-integrated, and system website(s) 127, etc.), without limitation. Components of the system may include television-based systems, radio-based systems, physical or electronic signs, pamphlets, magazines, newspapers, and internet-based advertising systems (e.g., digital screen billboards, paper/plaster-based billboards, highway signs), internet appliances and various other consumer products through which consumer purchases or auctions may be conducted, wireless or wearable computers (e.g., palm-based, wrist-wearable, implantable computing devices, mobile phones, Google Glass, etc.), instructions or communications regarding the same, functions, actions, executions, outputs regarding the same, combinations thereof, and the like, without limitation.

References throughout the foregoing description to features, advantages, or similar language do not imply that all of the features and advantages that may be realized with the present technology should be or are necessarily in any single embodiment of the invention. Rather, language referring to the features and advantages is understood to mean that a specific feature, advantage, or characteristic described in connection with an embodiment may be included in at least one embodiment of the present technology. Thus, discussion of the features and advantages, and similar language, throughout this specification may, but do not necessarily, refer to the same embodiment. Reference numerals used herein may have been used informally or interchangeably in order to convey certain relationships, similarities, or meanings between the subjects they identify; however, it should be duly noted that these reference numerals are not intended to limit the scope of the subjects they identify; nor are similar reference numerals intended to suggest that the features they depict are identical.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents, applications, and/or other references noted above, including any that may be listed in accompanying filing papers, are incorporated herein by reference in their entirety. It should be understood that not every aspect of every existing technology can be adequately described in detail in this application; however, it will be readily understood by those having an ordinary skill in the art, how existing technologies may be incorporated to successfully implement one or more aspects of the invention. Aspects of the invention can be modified, if necessary, to employ the systems, functions, features, steps, and concepts of the various references described above to provide yet further implementations of the invention.

Unless the context clearly requires otherwise, throughout the description and the claims, the words “comprise,” “comprising,” “may be,” “having,” and the like are to be construed in an open and inclusive sense, as opposed to an exclusive, exhaustive, or closed sense; that is to say, in the sense of “including, but not limited to.” As used herein, the terms “connected,” “coupled,” “communicating with”, “operably connected”, or any variant thereof means any connection, coupling, engagement, or communication (either direct or indirect), between two or more described elements; the connection, coupling, engagement, or communication between the elements can be physical, logical, figurative, or a combination thereof. It should be further understood that actions, steps, or figurative applications of the inventive features disclosed herein will obviously be accompanied by respective method steps, equipment, apparatus, hardware, and/or software, without limitation, which are necessary to perform the actions, steps, or figurative applications of the inventive features. Additionally, the words “herein,” “above,” “below,” “aforementioned,” “earlier,” “will be described,” “as previously discussed,” or “discussed in this disclosure” and words or phrases of similar import, when used in this application, refer to this application as a whole, including those applications incorporated by reference, and not to any particular portions of this application. Where the context permits, words in the above detailed description using the singular or plural number may also include the plural or singular number respectively. The word “or,” in reference to a list of two or more items, covers all of the following interpretations of the word: any of the items in the list, all of the items in the list, and any combination of the items in the list. Where used herein, the term “is”, may be interpreted broadly and openly to suggest “may be”, so as not to limit broader embodiments to a detailed depiction of a particular detailed embodiment. Where used herein, the terms “vendor,” “selling entity,” “retailer,” “merchant,” “participating entity,” “third-party,” “individual,” “user,” “system user,” “redeem-only user,” and the like, can be used interchangeably. Where used herein, the term “system” may refer generally to a system as a whole, and/or to one or more “components” of a system. A system “component” may include one or more broad or specific devices, features, concepts, or steps disclosed herein, without limitation. It should be understood that where used herein, a “terminal”, “register”, and similar terms (e.g., P-O-S checkout terminal, P-O-S, payment terminal, and the like) may be used interchangeably, and such terms may comprise a kiosk 3 or various components thereof, without limitation. Moreover such terms may refer to online payment receiving means 100, such as an online checkout page, without limitation.

The above detailed description of examples and certain embodiments is not intended to be exhaustive or to limit the invention to the precise form(s) disclosed above. While specific examples are described above for illustrative purposes, various equivalent modifications are possible within the scope of the invention, as those skilled in the relevant art will recognize. The teachings provided herein can be applied to other systems, including existing systems. The elements and acts of the various examples described above can be combined to provide further implementations or embodiments. Some alternative implementations or embodiments may include not only additional elements to those implementations noted above, but may include fewer elements. Furthermore, any specific numbers noted herein are only examples. Alternative implementations may employ differing values or ranges. Moreover, any specific commands or strings of characters, including text and numbers noted herein are only examples. Alternative implementations may employ differing commands or contents of character strings, text, and numbers other than what is shown.

While the above description describes various embodiments of the invention and/or the best mode(s) contemplated, regardless of how detailed the above text, the invention can be practiced in many ways beyond what is explicitly shown and described. Details of the systems and methods disclosed may vary considerably in its specific implementation, while still being encompassed by the present technology. As noted above, particular terminology used when describing certain features or aspects of embodiments should not be taken to imply that the terminology is being redefined herein to be restricted to any specific characteristics, features, or aspects of the invention with which that terminology is associated. In general, the terms used in the following claims should not be unduly construed to limit the claimed invention to the specific examples disclosed.

Accordingly, the actual scope of the invention encompasses not only the disclosed examples, but also all equivalent ways of practicing or implementing the invention under the claims. From the foregoing, it will be appreciated that specific embodiments of the invention have been described herein for purposes of illustration, but that various modifications may be made without deviating from the spirit and scope of the various conceivable embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims, and/or any claims which may be filed or amended in a continuing/divisional application.

Although certain aspects of the invention are presented below in certain claim forms, the applicant contemplates the various aspects of the invention in any number of claim forms. Accordingly, the applicant reserves the right to pursue additional claims after filing this application, and to pursue such additional claim forms, in either this application or in a continuing application.

### LISTING OF REFERENCE NUMERAL IDENTIFIERS

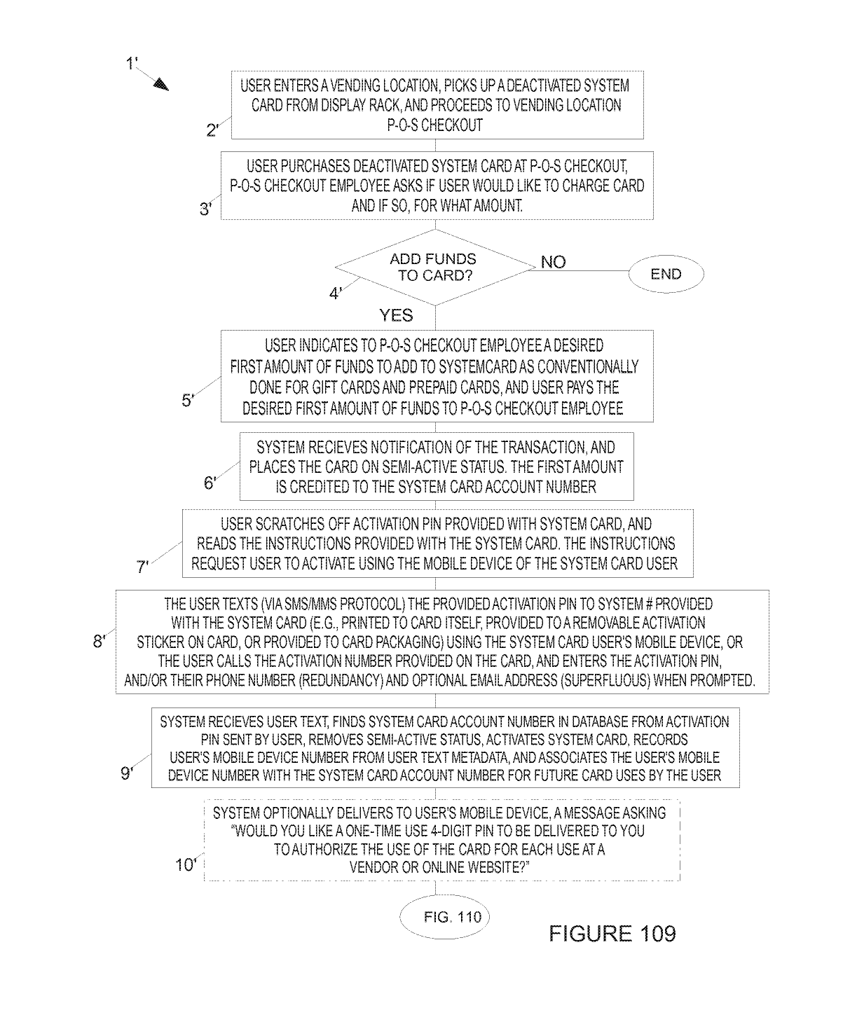

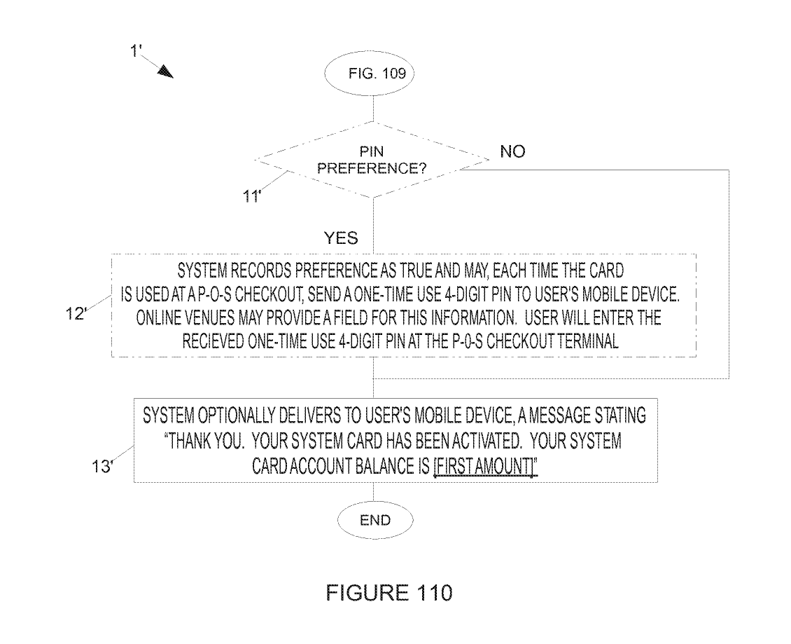

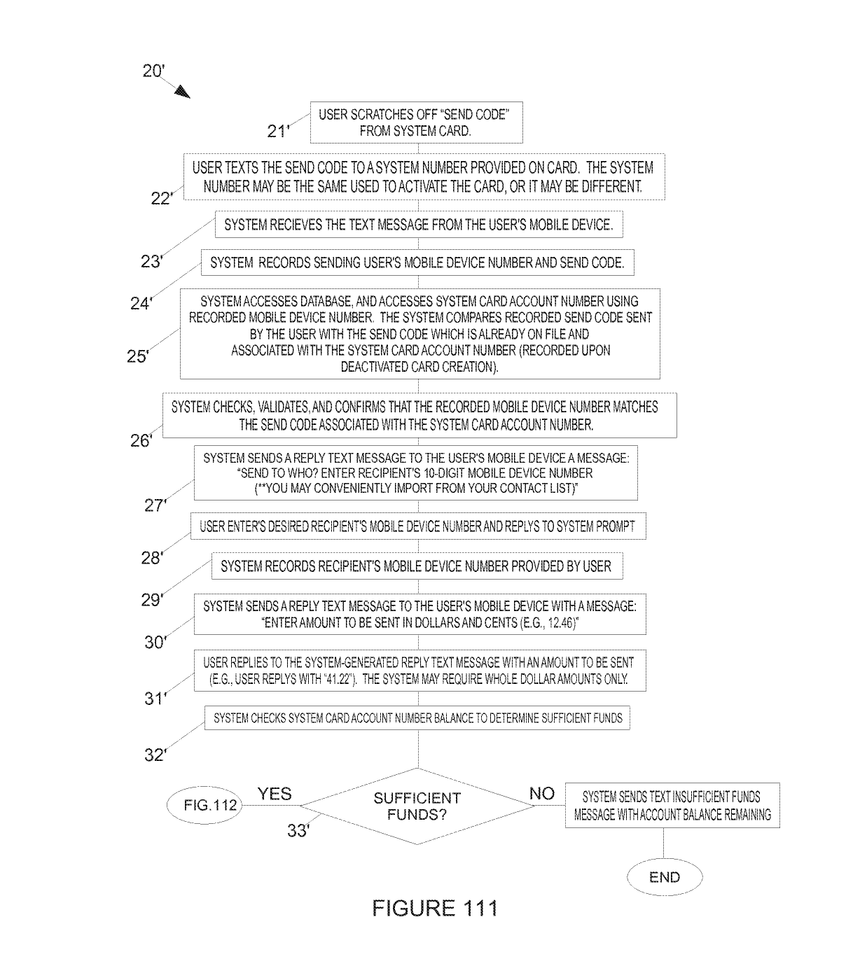

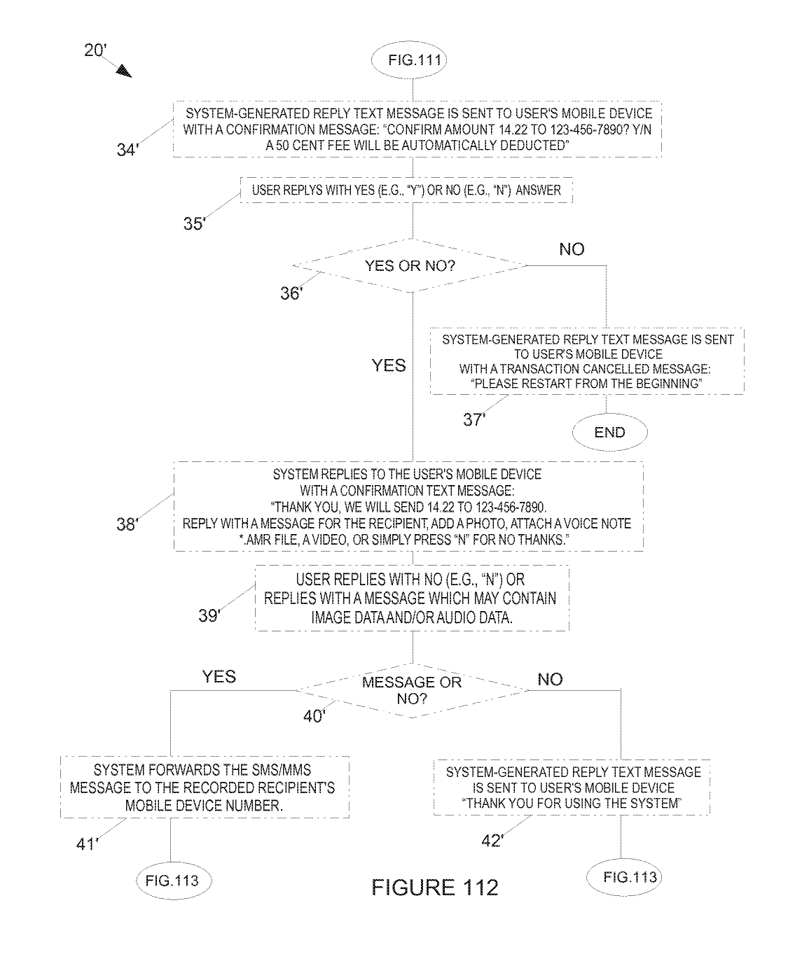

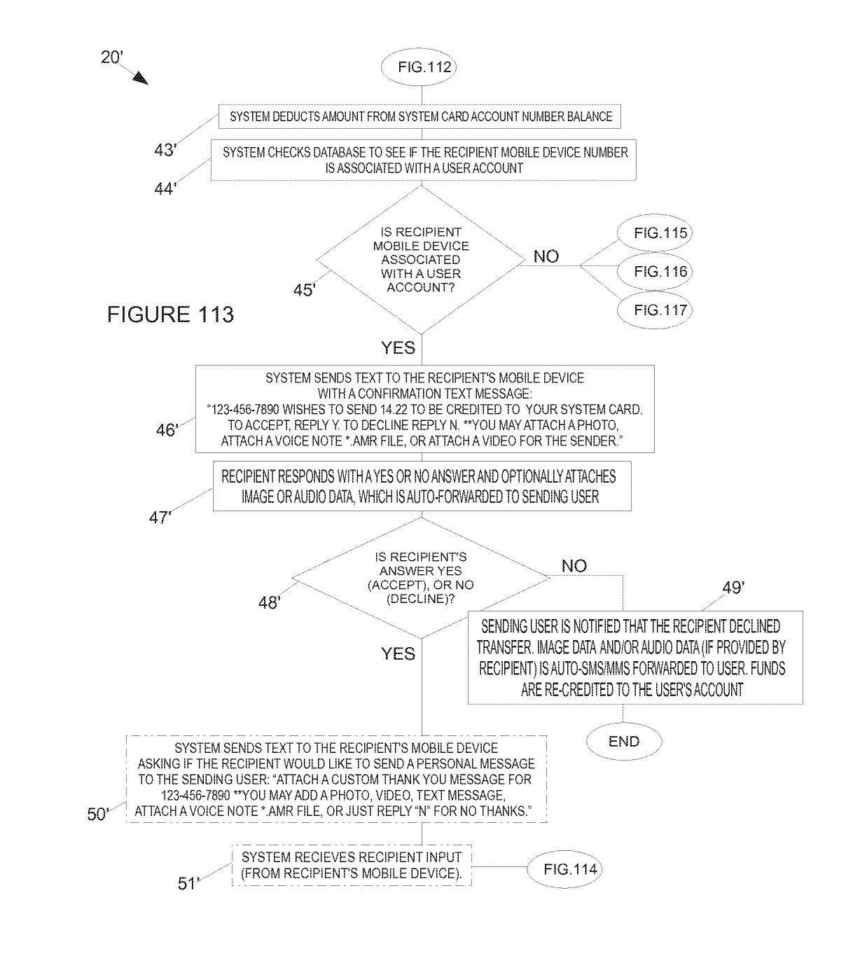

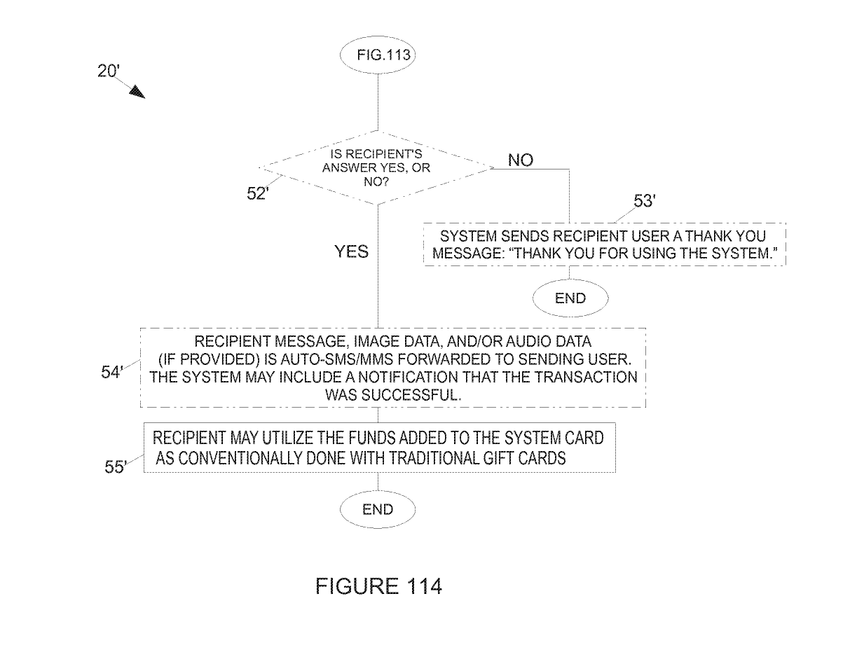

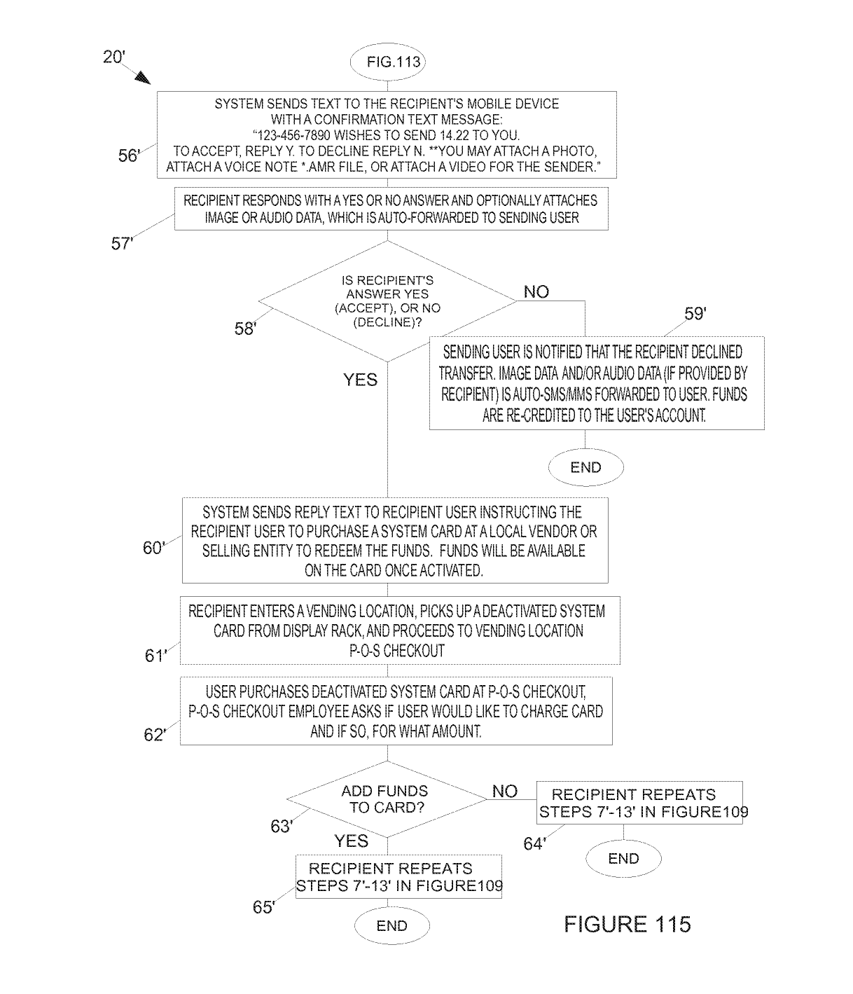

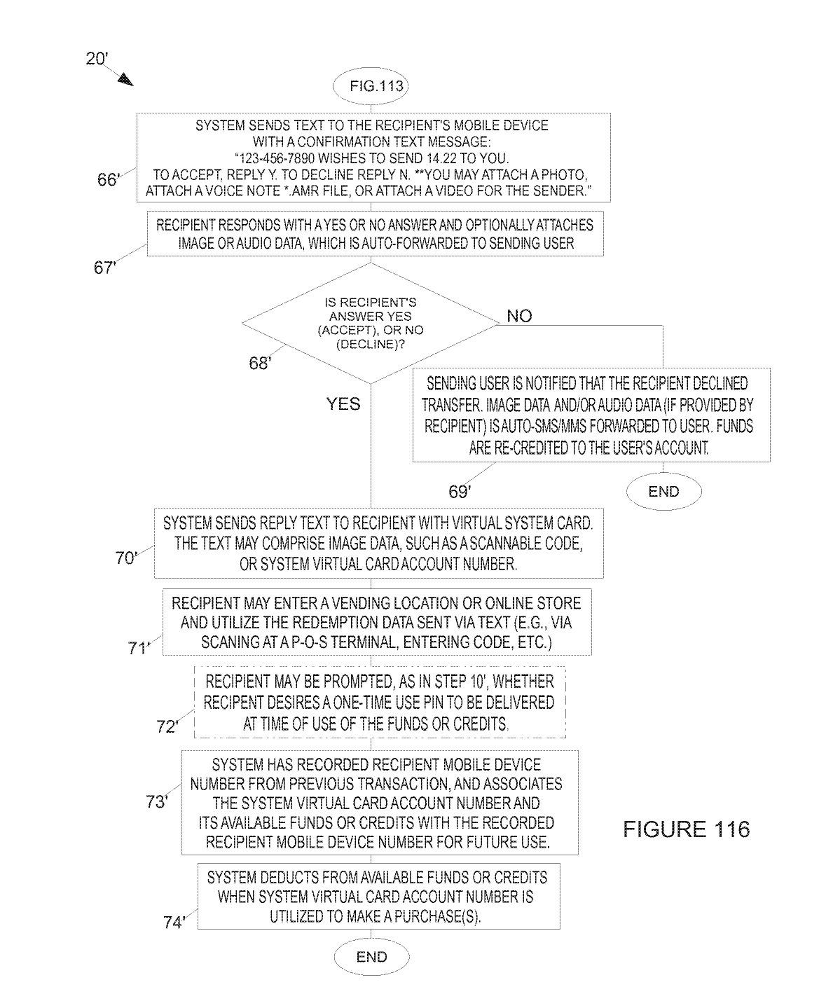

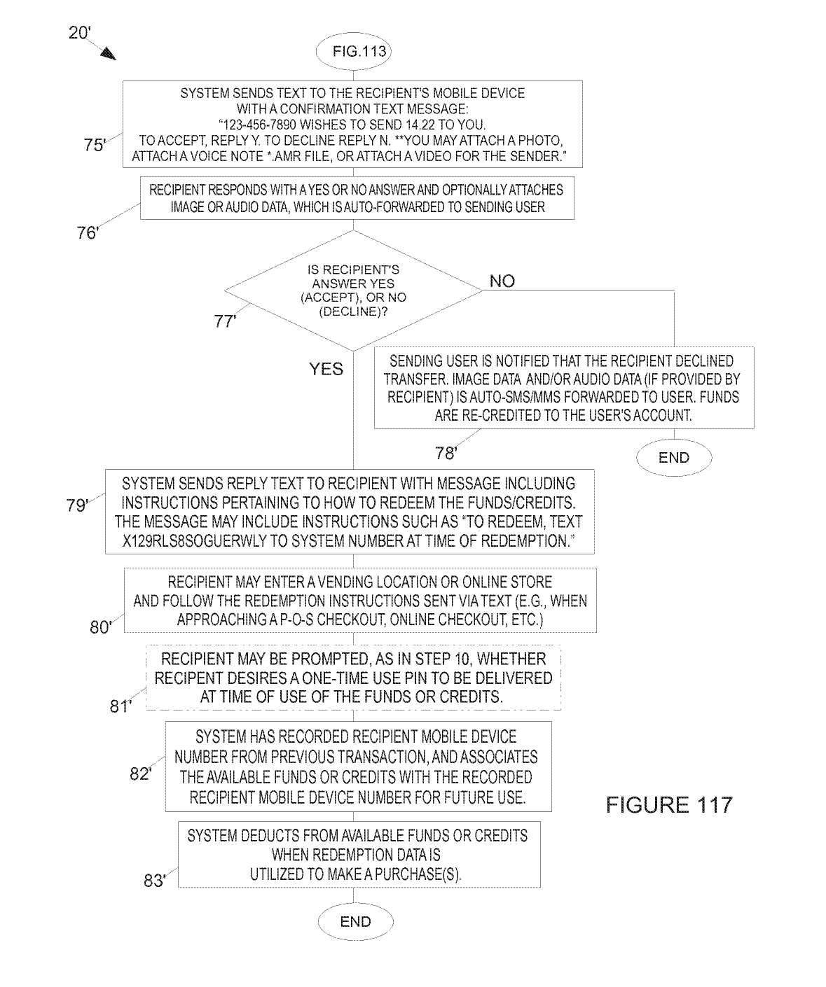

1—Conventional checkout/register, without limitation
2—Venue/Location (e.g., purchase location, point-of-sale, retail store, shopping mall, airport, park, gas station, convenience store, pharmacy), without limitation
3—Stand alone self-service kiosk, without limitation
4—Customer input(s) (inputs made by a user of the system, system website, or kiosk), without limitation
5—Output(s) (i.e., actions facilitated through or delivered via kiosk), without limitation
6—Image data (visual information, uploaded or selected picture/graphic/image/photo), without limitation
7—Audio data (e.g., acoustic information, sound file, sound recording from user or non-user of the system (e.g., general consumer shopping in a public participating location), without limitation
8—User data (information relating to a user of the system, system website, or kiosk), without limitation
9—Purchase data (information relating to a purchase using the system, system website, or kiosk)
10—Payment data (information relating to a form of funds or credit), without limitation
11—Cash/currency (e.g., cash, money, domestic currency, foreign currency, paper money, coin, legal tender, treasury note, money order, or information or data relating thereto), without limitation
12—Credit card (e.g., VISA, AMEX, DISCOVER, MASTERCARD, or credit card account information/data), without limitation
13—Debit card/electronic benefits transfer card (e.g., debit card, welfare/benefits card, electronic money, electronic funds transfer EFT card, bank card, or information relating thereto), without limitation
14—Check (e.g., personal check, cashier's check, bank check, corporate check, payroll check, tax refund check, corporate check), without limitation
15—Gift card (e.g., gift card (e.g., purchased online, bought at store, given to by third party), voucher, rain check, vendor-accepted funds or credit, gift certificate, system account card/kiosk-manufactured card, transferable or purchasable rewards/loyalty points, transferable or purchasable frequent flyer miles), without limitation
16—Coupon/Code (e.g., coupon, code, alphanumeric code, bar code, indicia associated with a discount, group discount coupon, vendor or entity-accepted funds or credit, sale code, savings code, online coupon code, promotional deal code, authorization code, frequent flyer miles), without limitation
17—Account number (e.g., bank account number, frequent shopper account, membership account number, credit card number, system user account (i.e., “profile 130”) number, financial assistance account number, account number rewards account number, customer account, escrow service account number, payment system account number (e.g., PayPal, merchant account, acquiring bank account number), without limitation
18—Digital/electronic currency (e.g., Bitcoin, cryptocurrency, digital gold/DGC currency), without limitation
19, 100, 200, 300, 400—Card (e.g., open loop/network card, closed loop card, hybrid closed loop card, rebate card, Mags Pangilinan-type cash card, restricted monetary equivalent card, scrip card, prepaid phone card, bank-issued gift card, credit card company-issued gift card, integrated circuit ICC card, smart card, RFID card, contactless card, magnetic stripe/magstripe card, electronic card, embossed card, printed card, keycard, access card, badge card, proximity card, stored-value card, security card, credential card, common access card, CR80.30 Composite PVCPET card, high coercivity mag stripe PVC card, CR80.13 mil graphic quality PVC card, low frequency (LF) RFID card (e.g., 125 kHz, 26, 34, 35, 36 & 37-bit formats), high frequency RFID card (e.g., 13.56 MHz MiFare ultralight, 1K, 4K, Desfire, etc.), ultra high frequency card (e.g., 840 to 960 MHz), MiFARE card (e.g., 4K, 1K, mini cards), ultralight and ultralight C RFID key card, EM4100/EM4102 system-supported card, BLANK NXP MiFare RFID card, chip card, ISO 7816-compliant contact card, multi-component card, memory card, CPU/MPU cards, vault card, fingerprint card, dual interface card, 12 mil plastic card, 30 mil plastic card), without limitation
20—Receipt (e.g., receipt information, physical receipt, electronic receipt), without limitation
21—Email (e.g., auto-generated email, automated message), without limitation
22—Confirmation number or code (e.g., auto-generated code), without limitation
23—Text/SMS message (e.g., auto-generated/automated message), without limitation
24—Voicemail (e.g., auto-generated/automated message), without limitation
25—Message information (e.g., greeting card message, display message, postal letter message), without limitation
26—Postage (e.g., printed, predetermined, stamps), without limitation
27—Currency (e.g., cash, money, currency, paper money, coin, digital/electronic currency, domestic currency, foreign currency, legal tender, treasury note, money order), without limitation
28—Data disk image (e.g., image on SD/mini-SD card, image on solid state drive, image on USB flash drive, image on compact disk, image on DVD, image on external drive, image on portable drive), without limitation
29—Scannable image (e.g., printed photograph, letter, document, card, displayed electronic image (e.g., phone or tablet screen), check, printed matter, graphic), without limitation
30—Texted image (e.g., image texted from smart/cell phone to kiosk-indicated number, image sent from tablet to kiosk via SMS messaging), without limitation
31—Phone image (e.g., image taken with cell phone, tablet, PDA, or portable computer screen which may be displayed proximate kiosk camera/image capture means or kiosk image scanning means, or transferred using a software application/app), without limitation
32—Emailed image (e.g., image from cell phone, tablet, PDA, or computer which is emailed to kiosk-indicated email address, Internet email transmission protocol, multipart/mime message, base64 encoded image in a data: url, HTML-formatted SMTP message, email attachment), without limitation
33—Camera image (e.g., image taken using kiosk camera/image capture means), without limitation
34—Web image (e.g., fair use/creative commons digital image selected from the internet using kiosk browser), without limitation
35—Hardwire/wireless uplinked image (e.g., phone, tablet, PDA or computer image uploaded to kiosk via cable (e.g., serial cable, FireWire, USB cable, Micro USB cable, IEEE 1394/1394a/1394b/1394c interface, i.LINK/Lynx interface) or wireless technology (e.g., Wi-Fi/IEEE 802.11, wireless LAN/WAN, cellular data service, wireless sensor/network, short-range wireless communications, infrared communication, Bluetooth/IEEE standard 802.15.1/EDR/LS, Link Management Protocol/LMP, Audio/Video Remote Control Profile/AVRCP, Logical Link Control and Adaption Protocol/L2CAP/ERTM/SM streaming mode, Service Directory Protocol/SDP, Radio Frequency Communications/RFCOMM, Bluetooth Network Encapsulation Protocol/BNEP, Audio/Video Control Transport Protocol/AVCTP, Audio/Video Distribution Transport Protocol/AVDTP, Telephony Control Protocol/TCS, Point-to-Point Protocol/PPP, TCP/IP/UDP, Object Exchange Protocol/OBEX, Wireless Application Environment/Wireless Application Protocol—WAE/WAP), PixDrop™ application or other multimedia Messaging Service/MMS)
36—Social media image (e.g., image selected from personal/shared/friend internet profile (e.g., Facebook), personal image storage website (e.g., Flicker, Picasa), social network/service, professional network (e.g., LinkedIn), or personal cloud drive (e.g., iCloud))
37—No image (e.g., option to select no imaged desired), without limitation
38—Stock or supplied image (e.g., selected from kiosk's searchable onboard database, hard drive, website, system database, or vendor/entity database), without limitation
39—Vendor image (e.g., logo, text, indicia, brand, trade dress, trademark, or graphic representative of particular participating vendor/entity), without limitation
40—Greeting card image (e.g., desired greeting card image(s) selected by user by any means discussed herein), without limitation
41—Message (e.g., text/alphanumeric/character-based input regarding desired message(s) to be printed on card or greeting card, fortune, phrase, quote, paragraph, passage, recipient information, donor information, greeting, tiding), without limitation
42—Design image (e.g., pattern, color, texture, sheen, gradient, background, puzzle, quiz, game, word art, brainteaser, stereoscopic image, 3D image, hologram), without limitation
43—System profile image (e.g., image instantaneously uploaded or pre-uploaded from phone, tablet, PDA, or computer to system website, system website profile image), without limitation
44—Password/Passphrase (e.g., spoken/verbal, may be a repetition of a phrase delivered to a user's voicemail, may be playback of a file containing a sound recording, may be uploaded or transferred from data disk or phone hard drive), without limitation
45—Sound bite/Digitone information (e.g., playback audio from voicemail, emailed or texted audio-containing file, uploaded sound recording), without limitation
46—Voice recording information (e.g., playback audio from voicemail, emailed or texted audio-containing file, uploaded sound recording, URL or other link connected to a digital audio-containing file), without limitation 47—Name information (e.g., last, first, middle, maiden, given/family, nickname, userID, screen name, account name), without limitation
48—Account number information (e.g., system website account number, credit card account number, banking account number, financial institution account number), without limitation
48a—Account balance(s) information (e.g., amount, value, or quantity of loyalty points, awards points, consumer-based credits, vendor-accepted funds or credits, etc.), without limitation
49—Email address information (e.g., email address), without limitation
50—Date of birth information (e.g., year, month, day, decade, age verification, age question prompts (e.g., over 18/21?), without limitation
51—Biological information (e.g., biometric information, DNA information, blood type information, fingerprint information, eye/retinal/iris information which can be gathered from a scan and used to identify a user, unique facial image information, B.P.A.C.-compatible biometric information or data, tattoo image information, facial expression information, voice or audio from vocal chords which may be interpreted and/or recognized using voice recognition software, heartbeat or cardiovascular pattern biometric information which can be recognized and used for identification purposes (e.g., Bionym device by NYMI), palm or other vein pattern information which may be authenticated using a vein authentication system/reader/infrared hemoglobin detector and associated software (e.g., PalmSecure by Fujitsu)), without limitation
52—Passport information (e.g., number, country, nationality, issue date), without limitation
53—Phone number information (e.g., cell number, landline number), without limitation
54—Address information (e.g., physical, home, work, current or former, nearest kiosk), without limitation
55—Credit card information (e.g., entire number, last four, security code, pin, electronic purse), without limitation
56—Frequent shopper information (e.g., flier miles, grocery card, gas, cash-back, rewards, account #), without limitation
57—License information (e.g., drivers, professional, certification), without limitation
58—Taxpayer information (e.g., social security number, resident number, birth certificate number, tax ID number), without limitation
59—Identification information (e.g., identification card, residency card, alien card, voter registration card, online profile ID/number, healthcare card, military ID, student ID), without limitation
60—Authorization information (e.g., security feature, crypto algorithm such as triple DES or RSA, password, passphrase, digital certificate, token, digital signature, public key infrastructure—PKI, encryption key, fob, pin, site-key, RFID/wireless keycard, FIPS 201-compliant device information, Smart Card Web Server (SCWS) information, SIM card data, non-repudiation data, data hash information, data encryption/decryption means, trusted third party TTP information), without limitation
61—Purchaser information, without limitation
62—Recipient information, without limitation
63—Preferences (e.g., language, location, favorites, friends/relatives, email/text/phone alerts, email/text/phone alerts notifications, information delivery methods), without limitation
64—Redemption data, without limitation
65—Participating vendor or entity (e.g., individual, user, organization, corporation, wholesaler, dealer, see FIG. 11), without limitation
66—Amount (e.g., purchased funds, credit, value, item), without limitation
67—Pass (e.g., toll lane access pass, VIP access, ski pass, ride-share, rail travel card/pass, entry access, admission, amusement park pass, entertainment pass), without limitation
68—Valid use date(s) (e.g., day, month, year, time, range), without limitation
69—Issue date(s) (e.g., day, month, year, time), without limitation
70—Expiration date(s) (e.g., day, month, year, time, range), without limitation
71—Partition information (e.g., for multiple purchases, transactions, or uses on a single card), without limitation
72—Type information, without limitation
73—Event details (e.g., venue/location, time, date, promotions, performers, team, game, performance, race registration, without limitation
74—Supplemental data (e.g., registration details, restrictions, vendor options, without limitation
75—Ticket (e.g., movie, play, sporting event, production, game/arcade, club, ski lift, bowl/skate, admission, integrated ticket, smart card, airline ticket, parking ticket), without limitation
76—Prepaid minutes (e.g., cell phone, calling card, massage, shop time, service, labor), without limitation
77—Image information (e.g., indicia, graphic, design, picture, text, photo, overlay, hologram, etching, embossment, logo, trademark, printed matter, pattern, lines, characters), without limitation
78—Points/credits (e.g., frequent shopper, frequent flier miles, member/membership, customer rewards, loyalty points, frequent diner points), without limitation
79—Barcode (e.g., 1D bar code, 2D bar code, QR code, universal product code/UPC, ISO/IEC 15416-compliant markings, ISO/IEC 15426-2 compliant markings, SO/IEC 15415-compliant markings, ISO/IEC TR 29158-compliant markings), without limitation
80—Audio information (e.g., voice-recording, sound bite, digitone, voice recognition token, audio file, sound-wave file), without limitation
81—Stock/Fund information (e.g., market identifier code, company name, international securities identifying number, ticker/stock symbol, National/international securities identifying number, CUSIP, certificates of deposit, syndicated loan information, tradable asset, IPO, wealth management account number, exchange traded fund ETF information), without limitation
82—Lottery/Bet voucher (e.g., scratch off, lottery ticket, proof of bet, wager receipt information), without limitation
83—Terms and conditions (e.g. restrictions, terms of use, waivers of liability, indemnifications, privacy terms), without limitation
84—Data storage means, without limitation
85—Solid state device, without limitation
86—Chip (e.g., integrated circuit, microprocessor, security authentication device, single sign on SSO device, EMV chip, ISO/IEC 7816 device, contactless “smart” ISO/IEC 14443-compliant device, inductor-comprising device, straight memory 1 k-1 Mbit Flash EEPROM I2C/SPI device, protected/segmented memory 3 k to 64 kbit EEPROM device, stored value memory, 8-bit Symmetric key/file-based 8-144 kB EEPROM, 8/16/32 bit public key dynamic 8 k-1 MB EEPROM with math coprocessor, 125 kHz proximity read-only device, 13.56 MHz ISO 14443 0.5-8 kB read/write device, MiFare protocol device, proprietary protocol device, ultrahigh frequency gen 1 or 2 device, semiconductor, proximity locator chip e.g., ScenSor DW1000 by DecaWave, IEEE 802.15.4a-compatible wireless communication device, NFC-compatible chip), without limitation
86—Solid state device, without limitation
87—Magnetic information storage means (e.g., high-coercivity HiCo means, low-coercivity—LoCo means), without limitation
88—RFID device (e.g., antenna, electromagnetic field device, tag, transponder, frequency modulating/de-modulating means, passive reader active tag device, active reader tag device, battery assisted tag BAT device, electronic product code EPC information, mobile computing communication device, virtual badge means, wireless tracking means, UHF inlays, smart labels, ultra strip III labels, theft prevention/security tag, electronic article surveillance EAS system-compatible tags), without limitation
89—Alpha-numeric information (e.g., text, characters, numbers, letters, printed indicia, embossed indicia, cryptotext), without limitation
90—Metadata (e.g., date, time, location, place of use, descriptive, structural, copyright/IP information, syntax, Hierarchical, linear/planar schemata, hyper-mapping data, granularity data, standardization information, cataloging information, technical information, business information, process information, cloud access information), without limitation
91—First user, without limitation
92—Second user, without limitation
93—Social media site(s) (e.g., personal website, networking website, business/professional development website, image sharing website, dating website, group/club website, meeting place website, social network service, Facebook, Twitter, WhatApp, Linkedin, YouTube, Blogger, Yahoo Groups, Instagram, Pinterest, system-based user network, etc., without limitation 94—Advertising/marketing/market research firm(s), without limitation
94—Advertising/marketing/market research firm(s), without limitation
95—Computer (e.g., CPU, laptop, tablet, server, terminal), without limitation
96—Mobile device (e.g., dumb phone, smart phone, cell phone, disposable phone, flip phone, tablet, smart watch, gaming device, laptop, VoIP-compatible device, Google Glass system, parasitic or stand-alone smart heads-up display system or head-worn computing device or computing device components, SIM card device, etc., without limitation
96A—Mobile device of first user 91, without limitation
96B—Mobile device of second user 92, without limitation
96C—Mobile device number or other communications information pertaining to a mobile device (e.g., electronic address, SIM card identification code, mobile device communications metadata, SMS center number information, mobile operator information, gateway information, etc., without limitation
97—CPU (e.g., motherboard, integrated circuit board, memory, processor, operating system, internet browser, internet protocol suite/TCP/IP network hardware and software, system/control/address/data bus, hardware, software, RS232 serial ports, USB ports, PCMCIA slots, floppy disk slots, parallel ports, infrared IRDA ports, terminal, keyboard/keyboard wedge interface), without limitation
98—Card production means (e.g. printing means, vending means, dispensing means etc.), without limitation
99—Security means (e.g., Encryption/decryption authorization protocol, security algorithms, security features, cryptographic/cryptologic algorithms, cryptosystems, plaintext to cipher-text encryption and decryption software, key/cipher, code, symmetric key ciphers, secure remote access/secure shell SSH client programs/network protocols/built-in architectures, transport/user authentication/connection layers, public key cryptography systems, RSA/DSA key exchanges, secure copy SCP protocols, FTP/SFTP transfer protocols, cryptographic hash functions, data encryption standard DES-compliant encryption algorithms, advanced encryption standard AES-compliant algorithms, public key infrastructures, modular multiplication/exponentiation means, Bitcoin client software/open source code, P2P networking, encoding schemes, digital wallet (e.g., Google wallet) security protocols, blockchain accessing functions, digital currency exchange client security protocols), without limitation
100—Payment receiving means (e.g., bill receiving means, coin receiving means, electronic funds transfer acceptance means, currency acceptance means, electronic funds or credits acceptance means, coupon code acceptance means, gift card acceptance means, credit/debit card acceptance means, electronic funds transfer EFT-POS terminal, hardware/software components, magnetic stripe reader, EMV/VSDC/Mchip/AEIPS/Jsmart/DPAS acceptance terminal, secure online payment submission webpage, remote deposit (capture) software, Check 21 Act-compliant online or direct deposit, mobile deposit software), without limitation
101—Internet connection means (e.g., Ethernet cable, LAN/WAN/GAN/3G/4G/LTE/LTE advanced compatible device, IP network, wired/wireless routing device, router, internet protocol suite TCP/IP-compatible device, ISP-software/hardware, IP address, modem device, server), without limitation
102—Image scanning means (e.g., charge-coupled device—CCD imagers, CCD reader, contact image sensor—CIS device, drum scanner, optical scanner, photomultiplier tube, rotary scanner, planetary scanner, 3D scanner, digital camera scanner, document scanning application/software/hardware, non-compressed RGB image processing means, raster graphics program, optical character recognition OCR software, sceyeX document camera, lens, light-source, photodiode, laser emitting means, imaging scanner, video camera reader, large field-of-view reader, omni-directional 1D or 2D barcode scanner/reader/position sensor, universal product code UPC scanner, pen scanner, handheld scanner, fixed position scanner, automatic reader, cordless scanner, decoding algorithm(s), serial interface, keyboard/mouse port, USB connector, wireless networking means, ISO/IEC 15416-compliant read device, ISO/IEC 15426-2 compliant read device, SO/IEC 15415-compliant read device, ISO/IEC TR 29158-compliant read device, B.P.A.C. device, MICR scanner), without limitation
102a—light emitting device or illumination source (e.g., infrared light-emitting LED), without limitation
103—Audio input means (e.g., microphone, VoIP device, electromagnetic induction device, acoustic-to-electric transducer, acoustic-to-electric sensor, piezoelectric device, fiber optic device, micro electrical-mechanical system MEMS device, speaker device, wireless audio device, interface, calibration means, filter, blimp/zeppelin device), without limitation
104—Printing means (e.g., card printer, embosser, liquid ink/inkjet printing device, dye sublimation printing device, ink-less/thermal printing device, laser printing/etching device, impact printing device, line matrix printer device, electrostatic printing device, photographic printing device, electrolytic printing device, spark printer device, barcode printing device, retransfer card printing device, laminating device, dye-sublimation retransfer device, dye sublimation thermal transfer direct to card printing device, reverse image technology printing device, thermal rewrite printing device, non-impact printing device multi-function printer—MFP, digital printer hardware, digital printer drivers/software, printer command language, Intermec RFID printer, page description language, card printer from Zebra, Evolis, Magicard, Datacard Group, Fargo, Nisca, Epson, Arojet, Dem-Jet UVA, Disen, ETA card, or ID Maker), without limitation
105—Greeting production means (e.g., toner-based printer, liquid inkjet printer, solid ink printer, dye-sublimation printer, ink-less printer, line printer, laser printer, dot-matrix printer, line matrix printer/comb printer, electrostatic printer, pen-based plotter, thermal printer, laser etching printer, blank cards, stationary, paper cards), without limitation
106—User interface (e.g., graphical user interface GUI, human machine interface HMI, human-computer interface—HCI, man-machine interface—MMI, schemata device, web based user interface WUI, touch screen, control panel, keyboard, mouse, command line interface, touch user interface, haptic feedback mechanism, attentive user interface, batch interface, conversational interface, crossing-based interface, gesture interface, intelligent user interface, motion tracking interface, multi-screen interface, non-command user interface, object-oriented user interface—OOUI, reflexive user interface, tangible user interface, task focused interface, text-based user interface—TUI, windows, icons, menus, pointer interface—WIMP, voice user interface, natural-language interface, zooming user interface, stylus/pen based interface (e.g., for authenticating signature on electronic checks)), without limitation
107—Advertising means (e.g., integrated marketing management software, customer insights and feedback processing software, qualitative algorithms, analytics software, customer relationship management CRM/SaaS software/systems, aggregate transaction information storage and access means, data collection software, B2C marketing automation tools/systems, inbound marketing automation tools/systems, search engine optimization SEO, social media marketing SMM, social software application, marketing automation tools/systems, voice-based marketing automation VBMA applications/software platforms, lead generation software, lead tracking software, lead scoring software, lead routing software, lead nurturing software, lead reporting software, CRM integration systems, hosted interactive voice response software, API integration protocols, software analytics enabled software, SMS/MMS messaging software and networking, online advertising management platform components, adware/advertising-supported software), without limitation
108—Payment dispensing means (e.g., physical payment dispensing means, electronic payment delivering means, bill/coin delivery mechanism, change calculating software/hardware, electronic payment/crediting software or system, credit adjusting software, account information updating software, application, wireless smart phone swipe crediting system, mobile tap and go device sticker system (e.g., MasterCard PayPass, VISA PayWave), smart phone/digital device payment application), without limitation
108a—Payment dispensing means icon (e.g., send partial or full funds or credits for a purchasable good or service to another user of the system, contact, relative, or friend, purchase a redemption option relating to a purchasable good or service for another system user, etc.), without limitation
109—Display means (e.g., LCD screen, LED/OLED screen, plasma display device, touch screen, electroluminescence EL device, gas discharge display, photoluminescence device, incandescence device, rear projection device, television screen, monitor, projector device, laser projection display), without limitation
110—Reader means (e.g., magnetic stripe reader, radio frequency/RFID reader, smart chip reader, integrated circuit reader, security authentication device reader, single sign-on SSO device reader, EMV device reader, contactless “smart” system device reader, inductor-comprising device reader, ISO 7816-compliant reader, MagTek, Inc. reader, ISO 14443-compliant reader, MiFare protocol reader, wireless smart phone swipe, mobile tap and go device sticker system (e.g., MasterCard PayPass, VISA PayWave), RFID antenna, RFID terminal, NFC-compatible device, wireless transceiver, transceiver suitable for wireless near field communication (e.g., a Bluetooth transceiver)), without limitation
111—Card dispensing means (e.g., printer tray, delivery mechanism, card dispenser), without limitation
112—Database/database access means (e.g., database management system (DBMS), SQL-compliant device, ODBC-compliant device, JDBC-compliant device, supporting database structures, database model(s), database server, multitasking kernel, networking support module, RAID disk array, XML model, application software, application programming interface, NoSQL/NewSQL database, document-oriented database, key value store, in memory database, active database, database triggers, cloud database, data warehouse, deductive database, distributed database, document-oriented database, embedded database system, end-user database, federated database system, multi-database, graph database, triple-stores, network database, hypertext database, hypermedia database, knowledge base database, mobile database, customer databases, parallel database, shared memory architecture, shared disk architecture, shared nothing architecture, probabilistic databases, real-time databases, spatial database, temporal database, terminology-oriented database, object-oriented database, unstructured data database), without limitation
113—Power supply means (e.g., hardwired cable, power cable, inverter, mains lead, plug, converter, adapter, fuse, interrupter), without limitation
114—Hardware link means (e.g., parallel port, general purpose interface bus GPIB, cable connector, small computer system interface SCSI such as ISIS, universal serial bus USB, FireWire, proprietary interface) applications programming interface API, SANE, TWAIN, Windows image acquisition WIA), without limitation
115—Data disk reader means (e.g., flash memory reader, solid state drive SSD reader, SD card reader, USB flash reader, compact disk reader, DVD reader), without limitation
116—Camera/Image capture means (e.g., digicam, webcam, digital camera, video camera, charge coupled (CCD) device, complementary metal oxide semiconductor (CMOS) sensor chip comprising device, optic, camcorder, infrared imaging device, thermal imager, personal computer camera configured to capture images in a predetermined wavelength range as known in the art, constant recording device (e.g., digital video camera), GoPro camera, automatic focusing feature, lens), without limitation
117—Data input means (e.g., touch screen, keyboard, keypad, voice recognition/command interpretation system, online data entry page, web-fillable HTML form, interactive screen, interactive website page, user prompt screen, user-fillable fields, stylus-based input device), without limitation
118—Internet or network (e.g., 3G UMTS CDMA-based, 4G LTE OFDMA-based, GSM network, TCP/IP internet protocol suite, Global System for Mobile Communications/GSM network, General Packet Radio Service/GPRS network, cdmaOne network, CDMA2000 network, Evolution-Data Optimized/EV-DO network, Enhanced Data Rates for GSM Evolution/EDGE network, Universal Mobile Telecommunications System/UMTS network, Digital Enhanced Cordless Telecommunications/DECT network, Digital AMPS/IS-136/TDMA network, and Integrated Digital Enhanced Network/iDEN network, Long-Term Evolution/LTE networks, High-Speed Downlink Packet Access/HSDPA networks, WiMAX networks, WCDMA networks, Internet Protocol Version 4/IPv4, Internet Protocol Version 6/IPv6), without limitation
119—Digital write means (e.g., magnetic stripe writer/encoder, EMV IC chip writer, ISO/IEC 15416-compliant write device, ISO/IEC 15426-2 compliant write device, SO/IEC 15415-compliant write device, ISO/IEC TR 29158-compliant write device, radio frequency/RFID writer, smart chip writer, integrated circuit writer, security authentication device writer, smartcard based single sign-on SSO support software, EMV device writer, contactless “smart” system device writer, inductor-comprising device writer, Intermec RFID printer hardware/software), without limitation
120—Postage means, without limitation
121—Product/offering information, without limitation
122—Financial server(s) (bank server, credit card company server, escrow service server, online payment system server (e.g., PayPal), acquiring bank server, virtual private server/farm/mine (e.g., Bitcoin server), depositary institution server, credit union server, trust company server, mortgage loan server, contractual institution server, pension fund server, investment institution server, investment bank server, underwriter server, brokerage firm server, corporate server), without limitation
123—Card storage means (e.g., hopper, magazine, blank card storage cartridge), without limitation
124—Housing (e.g., cabinet, enclosure, chassis, frame), without limitation
125—External server (e.g., data storage server, data center server, third party database server, third-party support service server, vendor/entity supporting server, third party online gift card exchange service server, online gift exchange website, online gift exchange website), without limitation
126—Sign-on/Login page, without limitation
127—System website, e.g. one or more integrated websites, without limitation
128—System server(s), e.g. one or more integrated servers, without limitation
129—System database(s), e.g. one or more integrated databases, without limitation
130, 130′—User profile (e.g., personal information, user data, friends/networks, favorites (e.g., commonly purchased products), system account information, recent transactions data (purchases, redemptions, and non-purchased, wish lists, gift lists, shopping lists, registry(ies), etc.), without limitation
131—Browser (e.g., system browser, application browser, system website-integrated browser, Avant browser, Google Browser (e.g., Chrome), Mozilla Firefox, Opera, Maxthon, Internet Explorer, Safari), without limitation
132—Check-out (physical terminal, payment terminal, payment environment, checkout page, or purchase page), without limitation
133—Cart (e.g., shopping list, products/offerings/types to be purchased, without limitation
134—Near field communication (NFC), without limitation
135—External database(s), without limitation
136—Vendor/entity server(s) (e.g., data storage database, data center database, third party database, third-party support service database, vendor/entity supporting database, third party online gift card exchange service database), without limitation
137—Vendor/entity database(s), without limitation
138—Financial database(s), without limitation
139—User homepage, without limitation
140—Favorites (e.g., favorite types or products/offerings/services on user's system profile account information, favorite vendors/entities of user, social media profile “Likes”, favorites or likes of user's friends, favorable opinion of a system user or a system user's contact(s), relative(s), or friend(s)), without limitation
140a—Dislikes (e.g., negative or unfavorable opinion or review of a redemption option, good, service, product, promotion, deal, vendor/entity, or offering), without limitation
141—Receipt means (e.g., receipt printer), without limitation
142—Updates (account # updates, system updates, system database updates, system website updates, system server updates, payment data updates, purchase data updates, redemption data updates, user data updates, audio data updates, image data updates, etc.), without limitation
143—Location data (e.g., product/offering sales location information, vendor/entity store layout information, information regarding product placement within a particular venue/location, information regarding a vendor/entity's geographic locations), without limitation
144—Shopping list information (e.g., wish lists, digital shopping list, gift lists, registries, Items/products/offerings/goods/services to buy etc.), without limitation
144a—Shopping list information icon (e.g., add to personal system wish list, add to a contact, relative, or friend's wish list, add to personal wish lists, add to personal shopping list, add to a contact/relative/friend wish list, add to one of a plurality of personalized gift lists of contacts/relatives/friends, add to a personal registry, add to another system user's registry, recommend another user of the system to add a product/offering/service to their wish list, etc., without limitation
145—Friends information (e.g., other system users, friends on system, friends from 3rd party websites, social networking friends, relatives, etc., without limitation
146—History information (transaction history, recent purchases, recent redemptions, shopping patterns, shopping interactions, recent kiosks visited, recent vendors/entities visited or shopped at, shopping frequency information, user tracking information, metadata), without limitation
147—Software (system-integrated software, application, instructions, code, syntax, executions, logic functions), without limitation
148—Third party application, without limitation
149—Shelving/display unit (e.g., shelf, rack, bookcase, display, counter, case, etc.), without limitation
150—Local antenna (e.g., multiple Wi-Fi hotspots, broadcast, interrogating signal-based, pinging, Android beam-based), without limitation
151—Product information (e.g., service, item, article, or information or data relating thereto), without limitation
152—Tag (e.g., RFID tag, printed RFID tag, smart tag, Gen-2 tag, smart label, tracking compatible emitter, passive device, active device, chip, reflector, asset tracking tag, anti-theft security tag), without limitation
153—Active Inventory Management System (e.g. RFID-tracking active shelf system, e.g., Barcoding Inc., tracking software, RFID interpreter, RFID reader, CaptureTech IGOR), without limitation
154—Tag (e.g., RFID tag, smart tag, chip, reflector), without limitation
155—Vendor/Entity security camera, without limitation
156—Vendor/Entity security system, without limitation
157—Security gate (e.g., turnstile, anti-theft system gate), without limitation
158—Areas of pause/heavy shopping by a user, without limitation
159—Positioning system (e.g., indoor positioning system (IPS), ViaLite Metro GPS, turnkey fiber optic remoting system, iBeacon (Apple) system or iBeacon-compatible system, Navizon or Navizon-compatible system, Meridian indoor GPS/positioning system, WiFarer indoor GPS/positioning system, WiGLE wireless geographic logging engine-based system, geographic location engines, Q-Track positioning system (e.g., NFER® system), DecaWave positioning system, Wi-Fi signal strength-based positioning system, cellular phone signal strength-based positioning system, Bluetooth signal-based positioning system, WiFiSLAM positioning system, Indoor Atlas positioning system, Low Energy (BLE) profile positioning systems for micro-location, marker-based positioning systems (e.g., Pathfindr), ZigBee-based intelligent indoor positioning system, visual guidance/vision guided navigational technology-based positioning system (e.g., SEEGrid), low power OEM UWB ranging platforms supporting two-way time-of-flight (TW-TOF) ranging and communications (e.g., Time Domain's PulsON® 410 (P410) module), other peer-to-peer ranging technology-based positioning systems, Sensormatic/theft prevention-based tag systems having possible redundancies in readers, cables, and antennas (e.g., Sensormatic iREAD™ platform, Sensormatic Ultra Max AM systems, magnetic/magneto-harmonic based positioning system, acoustomagnetic/magnetostrictive based positioning system, radio frequency-based positioning system (e.g., 1.75-9.5 MHz), Microwave-based positioning system, electromagnetic (EM) tag-based positioning system, RFID-based positioning system (e.g., SkyRFID), RFID/NFCemulator-based positioning system, video tracking-based positioning system (e.g., blob tracking-based, kernel/mean shift-based tracking, contour tracking, visual feature matching/registration-based tracking), user voice-based tracking, thermal/body temperature imaging-based positioning system, biometric recognition-compatible positioning system, ISO/IEC 24730 RTLS-compliant or non-compliant based positioning system, optical positioning system, radio-based positioning system, acoustic technology-based positioning system, Android beam-based positioning system, TecTile/sticker-based NFC-integrated positioning system, hybrid positioning system, motion-sensor-based positioning system, transponder-based positioning system, local positioning system, real-time locating system RTLS, etc.), without limitation
160—Vendor/Entity account information, without limitation
161—Greeting card (e.g., holder for a card, a mailable card, a postcard, stationary, etc.), without limitation
162—System client, without limitation
163—System financial institution, without limitation
200′—Method of distributing and receiving funds or credits according to some embodiments, without limitation (FIGS. 15-19)
201′-270′—Steps associated with method, without limitation (FIGS. 15-19)
300′—Method of distributing and receiving funds or credits according to some embodiments
301′-335′—Steps associated with method 300, without limitation
400—Article (e.g., card, ticket, paper-based article, plastic-based article, sticker, receipt, ticket, coupon, etc., without limitation
401—First layer (e.g., containing indicia or image data 6, such as printed matter), without limitation
402—Second layer (e.g., containing indicia or image data 6, such as printed matter), without limitation
403—Surface to which the first and second layers may be applied by printing, without limitation
1′—Method of purchasing, loading, and/or activating a system card, without limitation (FIGS. 109-110)
2′-13′—Method steps of purchasing, loading, and/or activating a system card, without limitation (FIGS. 109-110)
20′ —Method of sending funds, credits, offers, promotions, or items using an activated system card having loaded funds or credits thereon, without limitation (FIGS. 111-117)
21′-83′—Method steps of sending/receiving funds, credits, offers, promotions, or items using system card and mobile device, without limitation (FIGS. 111-117)
100A—System card of first user 91, without limitation
100B—System card of second user 92, without limitation (FIGS. 118-144b and 164-167):
100, 200, 300, 400—System card (e.g., open loop/network card, closed loop card, hybrid closed loop card, rebate card, Mags Pangilinan-type cash card, restricted monetary equivalent card, scrip card, pre-paid phone card, bank-issued gift card, credit card company-issued gift card, integrated circuit ICC card, smart card, RFID card, contactless card, magnetic stripe/magstripe card, electronic card, embossed card, printed card, keycard, access card, badge card, proximity card, stored-value card, security card, credential card, common access card, CR80.30 Composite PVC-PET card, high coercivity mag stripe PVC card, CR80.13 mil graphic quality PVC card, low frequency (LF) RFID card (e.g., 125 kHz, 26, 34, 35, 36 & 37-bit formats), high frequency RFID card (e.g., 13.56 MHz MiFare ultralight, 1K, 4K, Desfire, etc.), ultra high frequency card (e.g., 840 to 960 MHz), MiFARE card (e.g., 4K, 1K, mini cards), ultralight and ultralight C RFID key card, EM4100/EM4102 system-supported card, BLANK NXP MiFare RFID card, chip card, ISO 7816-compliant contact card, multi-component card, memory card, CPU/MPU cards, vault card, fingerprint card, dual interface card, 12 mil plastic card, 30 mil plastic card, gift card (e.g., purchased online, bought at store, given to by third party), voucher card, rain check card, vendor-accepted funds or credit card, gift certificate card, kiosk-provided card, transferable or purchasable rewards/loyalty points card, transferable or purchasable frequent flyer miles card, credit card (e.g., VISA, AMEX, DISCOVER, MASTERCARD), or credit card account information/data card), debit card/electronic benefits transfer card (e.g., debit card, welfare/benefits card, electronic money, electronic funds transfer EFT card, bank card, or information relating thereto))
101, 201, 301, 401—System card “how to use” instructions, without limitation
102, 202, 302, 402—Send funds code/address indicia, without limitation
103, 203, 303, 403—Request funds code/address indicia, without limitation
104, 204, 304, 404—Send item code/address indicia, without limitation
105, 205, 305—Buy item code/address indicia, without limitation
106, 206, 306—Like, or provide a favorable opinion code/address indicia, without limitation
107, 207, 307—Add to wish list code/address indicia, without limitation
108, 208, 308—Recommend to a friend list code/address indicia, without limitation
109, 209, 309, 409—System card “how to activate” instructions, without limitation
110, 210, 310, 410—System card barcode (e.g., 1D bar code, 2D bar code, QR code, universal product code/UPC, ISO/IEC 15416-compliant markings, ISO/IEC 15426-2 compliant markings, SO/IEC 15415-compliant markings, ISO/IEC TR 29158-compliant markings), without limitation
111, 211, 311, 411—Magnetic stripe (e.g., high-coercivity HiCo means, low-coercivity—LoCo means) or other data storage means used with payment terminals, including (e.g., a chip (e.g., integrated circuit, microprocessor, security authentication device, single sign-on SSO device, EMV chip, ISO/IEC 7816 device, contactless “smart” ISO/IEC 14443-compliant device, inductor-comprising device, straight memory 1 k-1 Mbit Flash EEPROM I2C/SPI device, protected/segmented memory 3 k to 64 kbit EEPROM device, stored value memory, 8-bit Symmetric key/file-based 8-144 kB EEPROM, 8/16/32 bit public key dynamic 8 k-1 MB EEPROM with math coprocessor, 125 kHz proximity read-only device, 13.56 MHz ISO14443 0.5-8 kB read/write device, MiFare protocol device, proprietary protocol device, ultrahigh frequency gen 1 or 2 device, semiconductor, proximity locator chip e.g., ScenSor DW1000 by DecaWave, IEEE 802.15.4a-compatible wireless communication device, NFC-compatible chip), a solid state device, an RFID device (e.g., antenna, electromagnetic field device, tag, transponder, frequency modulating/de-modulating means, passive reader active tag device, active reader tag device, battery assisted tag BAT device, electronic product code EPC information, mobile computing communication device, virtual badge means, wireless tracking means, UHF inlays, smart labels, ultra strip III labels, theft prevention/security tag, electronic article surveillance EAS system-compatible tags), without limitation
112, 212, 312, 412—Unique system account number (e.g., gift card account number, bank card account number, frequent shopper card account number, membership card account number, credit card account number, financial assistance/EBT card account number, rewards card account number, customer card account number, escrow service card account number, payment system account number (e.g., PayPal account number, merchant account number, acquiring bank account number, etc., without limitation
113, 213, 313, 413—Protective security sticker or scratch-off material layer, without limitation
114, 214, 314, 414—Revealed indicia layer (may be provided to a sticker 115 or printed directly onto card surface during manufacture of card 100, 200, 300, 400), without limitation
115, 215, 315, 415—Sticker/token (optional) may be removed from card and applied to a portion of a mobile device or other article for convenient access) device screen, without limitation
116, 216, 316, 416—Unique system account function codes (e.g., send funds code/address, request funds code/address, send item code/address, buy item code/address, “like” or provide a favorable opinion code/address, add to wish list code/address, recommend to a friend list code/address, request to see wish list code/address, request list of recent transactions code/address, see account balance code/address, report lost/stolen PIN code/address (for safekeeping on mobile device, paper wallet, or digital wallet), post to a profile code/address, etc., without limitation
117, 217, 317, 417—Activation code, without limitation

What is claimed is:

1. A method of sending funds or credits comprising:
a third electronic address receiving a first electronic communication from a first electronic address, wherein the first electronic communication comprises the third electronic address, wherein the first electronic communication comprises a second electronic address, wherein the first electronic communication comprises a first instruction, wherein the third electronic address is different from the first electronic address, and wherein the third electronic address is different from the second electronic address;
parsing, via software, the first electronic communication;
processing, via software, the first instruction utilizing the first electronic address and the second electronic address; and,
delivering, via software, a second electronic communication to the second electronic address, wherein the second electronic communication comprises first data pertaining to the first instruction.

2. The method of claim 1, wherein the first data pertaining to the first instruction comprises first transfer amount information, wherein the first transfer amount information comprises a first amount of funds to be transferred from a first account associated with the first electronic address to a second account associated with the second electronic address.

3. The method of claim 2, further comprising, via software, accessing a database containing the first account associated with the first electronic address, determining first account balance information associated with the first account, comparing the first account balance information with the first transfer amount information, and determining if the first account balance information is sufficient to comply with the first instruction; wherein the step of delivering a second electronic communication to the second electronic address is performed if the first account balance information is sufficient to comply with the first instruction.

4. The method of claim 2, wherein first instruction comprises the first transfer amount information.

5. The method of claim 1, wherein the first data pertaining to the first instruction comprises first redemption information having a first redemption information value, wherein the first redemption information comprises a first code which is configured to be exchanged for at least one of the group consisting of: a first item, a first product, a first good, and a first service.

6. The method of claim 5, wherein the first code comprises at least one of the group consisting of: a machine-readable image, a machine-displayable image, a machine-readable sound, a machine-interpretable sound, and a character string.

7. The method of claim 6, wherein the first code further comprises at least one second code, the at least one second code comprising at least one of the group consisting of: a machine-readable image, a machine-displayable image, a machine-readable sound, a machine-interpretable sound, and a character string.

8. The method of claim 5, wherein the first redemption information comprises first redemption amount information pertaining to the first redemption information value, wherein the first redemption amount information comprises a first amount of funds to be debited from a first account associated with the first electronic address, as a condition of software complying with the first instruction.

9. The method of claim 8, further comprising, via software, accessing a database containing the first account associated with the first electronic address, retrieving first account balance information associated with the first account, comparing the first account balance information with the first redemption amount information, and determining if the first account balance information is sufficient to comply with the first instruction; wherein the step of delivering a second electronic communication to the second electronic address is performed if the first account balance information is sufficient to comply with the first instruction.

10. The method of claim 5, wherein the first instruction comprises an item code, wherein the item code comprises a character string, and wherein the character string comprises at least one of the group consisting of: a GTIN number, a UPC number, an SKU number, a trademark, and a description; wherein the description comprises a string of characters which is representative of the first item, the first product, the first good, and the first service.

11. The method of claim 1, wherein the step of a third electronic address receiving a first electronic communication from a first electronic address comprises the third electronic address receiving the first electronic communication from the first electronic address via a first platform comprising a first communication protocol; wherein the step of delivering a second electronic communication to the second electronic address via software comprises delivering the second electronic communication to the second electronic address via a second platform comprising a second communication protocol; wherein the first communication protocol is different from the second communication protocol, and/or the first platform is different from the second platform.

12. The method of claim 11, wherein the first platform comprises an environment selected from one of the group consisting of: an email-based environment, a web-based environment, an application-based environment, a mobile messaging application-based environment, a short message service (SMS)-based environment, a multimedia message service (MMS)-based environment, a telephonic-based environment, and a social media-based environment; and wherein the second platform comprises an environment selected from one of the group consisting of: an email-based environment, a web-based environment, an application-based environment, a mobile messaging application-based environment, a short message service (SMS)-based environment, a multimedia message service (MMS)-based environment, a telephonic communication-based environment, and a social media-based environment.

13. The method of claim 11, wherein the first electronic address comprises an electronic address selected from one of the group consisting of: an email address configured to be used within an email-based environment, a GUID configured to be used within a web-based or application-based environment, an IP address configured to be used within a web-based or application-based environment, a screen name configured to be used within a web-based or application-based environment, a phone number configured to be used within a telecommunications-based environment, and a social media screen name configured to be used within a social media-based environment; and wherein the second electronic address comprises an electronic address selected from one of the group consisting of: an email address configured to be used within an email-based environment, a GUID configured to be used within a web-based or application-based environment, an IP address configured to be used within a web-based or application-based environment, a screen name configured to be used within a web-based or application-based environment, a phone number configured to be used within telecommunications-based environment, and a social media screen name configured to be used within a social media-based environment;

14. The method of claim 11, wherein the first electronic communication is selected from one of the group consisting of: an electronic mail message, a web-based submission, an application-based submission, a mobile messaging application electronic message, a short message service (SMS) electronic message, a multimedia message service (MMS) electronic message, a wireless phone call, a landline phone call, an instant message, an electronic forum message, and a social media post; and wherein the second electronic communication comprises at least one of the group consisting of: an electronic mail message, a web page link, an application-based alert, a mobile messaging application electronic message, a short message service (SMS) electronic message, a multimedia message service (MMS) electronic message, a phone call, a voicemail, a landline phone call, an instant message, an electronic forum private inbox message, a direct messaging (DM) electronic message, a PUSH-based message, and a social media post.

15. The method of claim 1, wherein the first electronic communication further comprises a fourth electronic address; the method further comprising the steps of:
processing, via software, the first instruction utilizing the fourth electronic address; and,
delivering, via software, a third electronic communication to the fourth electronic address, wherein the third electronic communication comprises second data pertaining to the first instruction.

16. The method of claim 15, wherein the first instruction comprises transfer amount information, wherein the transfer amount information comprises an amount of funds to be transferred from a first account associated with the first electronic address to a second account associated with the second electronic address, wherein the transfer amount information further comprises an amount of funds to be transferred from the first account associated with the first electronic address to a third account associated with the fourth electronic address, the method further comprising the steps of:
determining a total amount of funds to be debited from a first account associated with the first electronic address;
accessing a database containing the first account associated with the first electronic address;
debiting the first account associated with the first electronic address by the total amount of funds to be debited;
optionally creating a second account associated with the second electronic address if the second account associated with the second electronic address does not exist;
optionally creating a third account associated with the fourth electronic address if the third account associated with the fourth electronic address does not exist;
crediting the second account associated with the second electronic address by the amount of funds to be transferred from a first account associated with the first electronic address to a second account associated with the second electronic address; and,
crediting the third account associated with the fourth electronic address by the amount of funds to be transferred from a first account associated with the first electronic address to a second account associated with the second electronic address;

17. The method of claim 16, wherein the second electronic address is different than the fourth electronic address, and wherein the second electronic address is a different type of electronic address than the fourth electronic address.

18. The method of claim 15, wherein the first instruction comprises an item code associated with redemption information having a redemption information value, the item code comprising an item code purchase cost, the method further comprising the steps of:
determining a total amount of funds to be debited from a first account associated with the first electronic address;
accessing a database containing the first account associated with the first electronic address;
debiting the first account associated with the first electronic address by the total amount of funds to be debited;
crediting a second account associated with the second electronic address with redemption information;
crediting a third account associated with the fourth electronic address with redemption information;
optionally creating a second account associated with the second electronic address if the second account associated with the second electronic address does not exist;
optionally creating a third account associated with the fourth electronic address if the third account associated with the fourth electronic address does not exist;
wherein the first data pertaining to the first instruction comprises first redemption information relating to the item code, the first redemption information being configured to be exchanged for at least one of the group consisting of: a first item, a first product, a first good, and a first service; and,
wherein the second data pertaining to the first instruction comprises second redemption information relating to the item code, the second redemption information being configured to be exchanged for said at least one of the group consisting of: a first item, a first product, a first good, and a first service.

19. The method of claim 18, wherein the second electronic address is different than the fourth electronic address, wherein the second electronic address comprises a first type of electronic address, wherein the third electronic address comprises a second type of electronic address, and wherein the first type is different from the second type.

20. The method of claim 19, wherein the step of delivering a second electronic communication to the second electronic address via software comprises delivering the second electronic communication to the second electronic address using a second platform comprising a second communication protocol; wherein the step of delivering a third electronic communication to the fourth electronic address comprises delivering the third electronic communication to the fourth electronic address using a third platform comprising a third communication protocol; and wherein the second communication protocol is different from the third communication protocol, or the second platform is different from the third platform.
